(19) United States
(12) Patent Application Publication
(10) Pub. No.: US 2026/0121095 A1
(43) Pub. Date: Apr. 30, 2026

(54) Advanced Ion Exchange Membranes And Applications Thereof

(71) Applicant: Richard Kent Williams, Cupertino, CA (US)

(72) Inventors: Richard Kent Williams, Cupertino, CA (US); Yi Zheng, Canton, MA (US); Chris Scott Graham, Palo Alto, CA (US); Keng Hung Lin, Zhubei City (TW); Khushnood Ahmad Qazi, Los Alos, CA (US)

(21) Appl. No.: 18/973,042

(22) Filed: Dec. 8, 2024

Related U.S. Application Data
(63) Continuation-in-part of application No. 18/756,703, filed on Jun. 27, 2024.
(63) Continuation-in-part of application No. 18/773,948, filed on Jul. 16, 2024.
Application No. 18/773,948 is a continuation-in-part of application No. 18/756,703, filed on Jun. 27, 2024.
(60) Provisional application No. 63/511,384, filed on Jun. 30, 2023.
(60) Provisional application No. 63/513,890, filed on Jul. 16, 2023.
(60) Provisional application No. 63/608,395, filed on Dec. 11, 2023.
(60) Provisional application No. 63/608,395, filed on Dec. 11, 2023.

(51) Int. Cl. H01M 8/1065; C25B 13/08; H01G 11/56; H01M 8/10; H01M 8/1011; H01M 8/1025; H01M 8/1032; H01M 8/1034; H01M 8/1039; H01M 8/1048; H01M 8/1051; H01M 10/0565

(52) U.S. Cl. CPC H01M 8/1065; C25B 13/08; H01M 8/1011; H01M 8/1025; H01M 8/1032; H01M 8/1034; H01M 8/1039; H01M 8/1048; H01M 8/1051; H01M 10/0565; H01G 11/56; H01M 2008/1095; H01M 2300/0082

(57) ABSTRACT

Improved performance ion exchange membranes for use in PEM, AEM and DMFC fuel cells, buffered fuel cells, hydrolysis, other applications comprise a molecular matrix of homopolymers, di-monomer, heteropolymers, copolymers, or block-polymers of fluorocarbon and hydrocarbon compounds combined with (i) skeletal support grid to improve durability, handling, reduce membrane swelling, and sequester dopants and nanoparticles from leakage; (ii) microporous membrane formed using a sacrificial filler process enhancing conductivity and limiting fuel crossover; (iii) hetero-ionomeric matrix of two-or-more membrane-bound acids e.g. sulphonic and phosphonic acid expanding usable range; (iv) permanent fillers enhancing conductivity and porosity including nanoparticles, metal-oxides, zeolites, silicates, GOs, CNTs, MOFs, POSS, and others; (v) ionic liquid doping to enhance membrane conductivity; (vi) membrane nanocoating preventing H₂O₂ diffusion; and/or (vii) catalytic nanocoating with metals, metal-oxides, and MOFs preventing atmospheric toxin catalyst poisoning. Combined with a heterogenous GDL, the IEM is integrated into iBFC power blade and energy bank applications.

### CROSS-REFERENCE TO RELATED APPLICATIONS

This application claims the priority of U.S. Provisional Application No. 63/608,395, titled “Ion Exchange Membranes and Applications Thereof,” filed on Dec. 11, 2023.

This application is a continuation-in-part of the following applications: U.S. application Ser. No. 18/756,703, titled “Intelligent Buffered Fuel Cell with Low Impedance,” filed on Jun. 27, 2024, and U.S. application Ser. No. 18/773,948, titled “Advanced Fuel Cell—Design, Apparatus, & Fabrication,” filed on Jul. 16, 2024.

### SCOPE OF THE INVENTION

The invention relates to the fabrication of ionomeric membrane and their application in fuel cells and other electrochemical devices.

Each of the foregoing applications is incorporated herein by reference in its entirety.

### BACKGROUND OF THE INVENTION

The availability of clean reliable electrical energy is becoming increasingly important in modern technological society as it is plays a pivotal role in nearly every activity and industry today. Applications requiring electrical power include computing; communication, networking; and the Internet; transportation; telephony; wired and wireless networks; consumer electronics and entertainment; home appliances; medical devices; security systems; motor drive; satellites; defense; and emergency response. Industries, enterprises, and personal uses relying on electrical power are far ranging, including business, commerce, and banking; residential and commercial buildings; infrastructure; factories and heavy industry; farming and agriculture; biotech and medtech; semiconductors and electronics; avionics, aircraft, airlines, and space travel; boats, ships; trains and rail transport; automobiles and trucks; motorbikes, all terrain vehicles (ATVs) and scooters; hospitals, clinics, and healthcare; computer and server farms; and more. Even electrical power generation requires electricity to manage control functions.

Newsworthy topics in power today include renewables, autonomy, reliability, emergency backup, uninterrupted power, remote location power, mobility, space & avionics, energy self-reliance in residential power, and increasing the payload and reducing the cost in shipping. Power may be categorized in a variety of ways including primary vs secondary power, fixed infrastructure versus mobility, AC vs DC distribution, and centralized vs distributed systems.

### Primary Power.

The source of power this myriad of electrical applications can be categorized into two classes: primary power and secondary power. Primary power is a fundamental source of energy occurring in nature and converted into electricity generally using mechanical motion of turbine turning a generator. A generator converts rotary or in some cases linear motion into electric current in accordance with Faraday's law by juxtaposing a magnet and a coil. In operation, one of the two elements, either the coil or the magnet is constantly moving relative to the other element, thereby magnetically inducing electric current in the coil. The output of a generator, i.e. the current induced in the conductive coil, may be alternating current (AC) or direct current (DC). A variant of a generator, called an alternator, produces only AC.

The force producing kinetic movement of a generator rotor may come from a variety of sources including thermal energy used to boil a fluid to turn a turbine. Primary power thermal sources include natural heat (geothermal, concentrated sunlight); chemical reactions or burning of fossil fuels releasing heat including coal, natural gas, refined oil products, and biofuels; or nuclear reactions used to generate heat via fission of heavy atoms (or potentially fusion of hydrogen). All primary power sources suffer from some major limitation. In primary power generation, the burning of fossil fuels, especially coal, is largely responsible for most air pollution and anthropogenic carbon dioxide releases. Among fossil fuels, natural gas represents the cleanest source of power.

Although nuclear power is free of greenhouse gasses, the disposal and storage of nuclear waste represents a significant environmental challenge and safety risk. Another major issue with present day liquid-cooled nuclear plants is their need to be located near large bodies of water such as rivers, lakes, and oceans. Unfortunately uncontrolled heating of the nuclear core, i.e. nuclear meltdown, can irrevocably contaminate water supplies causing radiation poisoning and cancer in residents, and poison livestock, fish, vegetables, and other food stuffs. Notorious nuclear disasters include the Three-Mile Island and Chernobyl Ukraine.

Another serious risk of nuclear power plants being located on the ocean is the risk of tsunami damage to the reactor facility itself. For example, on Mar. 11, 2011 the Fukushima nuclear disaster in Tohoku Japan occurred as a result of 9.1 magnitude quake followed by 14 meter high tsunami. The tsunami damaged the emergency generators causing backup power loss to circulating coolant pumps resulting in the nuclear meltdown of three nuclear cores. The cascade of failures simultaneously killed two people from radiation, burned 16 persons from hydrogen explosions, and released 18,000 terabecquerel (TBq) of radioactive cesium-137 into the Pacific during the accident.

Since this event, much of the world are now decommissioning nuclear fission power plants. As a safer cleaner alternative source of energy, the kinetic motion of fluids (wind, falling water, ocean waves) may be converted into electricity using a turbine and generator. Falling water also referred to as hydroelectric power is however limited geographically to rivers and lakes, including artificial lakes creating by dams. Although the hydroelectric energy production is carbon free, the use of dams is opposed by many environmentalists for disrupting wildlife and destroying wildlife habitats. Recently modern wind farms located in windy offshore locations have come under increased scrutiny for causing whale beachings and bird deaths.

Geothermal power, although considered green power, is geographically limited, specifically to within the vicinity of volcanos and hot springs where magma penetrates the mantle into the earth's upper crust. Unfortunately volcanos are often associated with magmatic and tectonically active areas where earthquake risk and steam explosions must be considered as a safety hazard.

Solar energy, harvesting energy from sunlight, comes in two forms—thermal-solar power generation and direct photon conversion referred to as photovoltaic or PV. In thermal-solar plants sunlight is focused by mirrors to a central boiler used to generate steam and drive turbines producing AC power. Despite its theoretical potential, commercial deployment of thermal-solar power production has proven to be technologically and economically unviable. Firstly, thermal-solar power generation requires large tracts of land where sunlight is plentiful and the sky is consistently free of clouds. As land is expensive, most thermal-solar power facilities must be located in deserts far from population centers. The long distance delivery of electrical power is however extremely problematic, especially using AC transmission.

Further complicating matters, diurnal temperature variations in dessert climates are extreme, ranging from below freezing in the night hours to over 55° C. (130° F.) by the afternoon. These large daily excursions in operating temperature have been found to degrade mirrors, warp metal, and damage equipment resulting in unmanageably high repair and maintenance costs. As such, several large projects solar-thermal projects have been abandoned. The alternative, centralized power generation via direct energy conversion of sunlight using photovoltaic (PV) cells is similarly uneconomical, requiring vast swaths of land covered by expensive solar panels. Using cheaper land located far from metropolitan areas is even more problematic than solar-thermal farms as PV cells produce direct current, not AC power. High-voltage DC power transmission over large distances is currently too complex and expensive to be considered a viable technology for primary power.

A more attractive alternative is to employ photovoltaic power generation, not as primary power for the electric grid, but locally as residential power generation for personal use. While the use of solar panels placed atop houses, apartments, and garages is becoming popular, it too faces serious technology and commercial challenges. Specifically, most residential solar owners use a solar inverter to convert DC into AC and to dump the power they generate back into the AC power grid receiving billing credits for “negative” power flow. This practice is intrinsically flawed and limited in its ability to scale. Firstly, like wind generation, solar power varies unpredictably with weather patterns and with cloud cover resulting in intermittent power unable to ensure a steady rate of power. Intermittent power can cause noise, power factor fluctuations, and destabilize the power grid impacting power quality for all users.

To offset the destabilizing impact of client-generated intermittent solar power, power utilities are forced to generate more AC power to mitigate transients and maintain a constant frequency for transmission. This action requires the utility burn more fossil fuels to counteract the intermittent power with generator power. Ironically, the more renewable energy is fed into the power grid, the more fossil fuel must be burned to compensate to create the grid working. As a result, many utilities no longer give credits to users for the power they generate. Instead, home owners and apartments are being asked to locally store the energy they generate.

The need for local power storage is part of even a broader topic—peak electrical demand management. A principal issue with primary power is the difficulty of synchronizing power generation with power consumption. Specifically when power is plentiful, energy consumption may not be sufficient to utilize the generated power, causing power to go wasted. Conversely in times of peak demand, e.g. in the early evening, renewable sources such as solar are not be available, forcing increased production using fossil fuels causing pollution and requiring higher current handling capacity of power transmission lines.

The diurnal energy cycle, the so called ‘duck curve’ forces utilities to buy PV generated energy from its clients even when the utility has no one to sell the power to. The term the duck curve reflects the shape of the curve of net PV energy use versus time-of-day where most energy consumption occurs in the late morning and again in early evening but not in mid afternoon. Unfortunately, in the mid afternoon when the sun is brightest and PV output is at its peak, the power grid does not have enough customers consuming power to offset the power they receive from PV generation. It such instances, the utility must buy power it cannot use or sell.

Worse yet the excess power must be burned to avoid destabilizing the power grid. i.e. the utility grid suffers net negative energy receiving more than the deliver. The negative grid energy issue is especially problematic in California where the state's green policies have encouraged and even subsidized the overproduction of solar power with no plans or provisions for using or storing the excess power. To avoid financial losses from negative PV energy some power utilities simply refuse to buy power from residential and commercial PV production. This policy is easily implemented at the smart meter by disconnecting the client from the AC mains whenever the net energy becomes negative.

Another solution to this problem for the utility companies is asymmetric pricing, where the utility pays far less to buy energy than they do to sell it back to the same customer. For example the power company may purchase PV power from its clients at $0.05 per kWh and then later in the day sell it back to them at $0.50 per kWh, ten times higher. In this approach, the more people spend on installing solar power, the more profit the power utility makes. In essence the consumer is subsidizing the power company, not the alternative. The only choice is for the consumer is to store the excess power they make themselves. Unfortunately today the only way to store power at home is using expensive arrays of lithium ion batteries.

For example, for an average home consuming total of total of 33 kWh, using Li-ion cells as a storage medium is expensive and heavy. For 18650 cylindrical cells holding between 8 to 12 kWh and weighing 46 grams each, the number of cells needed to supply 33 kW is between 2,750 to 4,125 cells weighing from 127 kg to 190 kg in total corresponding to a gravimetric energy density of 173 to 260 kWh/kg. By contrast, a cylindrical lithium ion battery in a 21700 form factor holds between 15 to 20 Wh while weighing 63 grams each. Accordingly, the number of 21700 cells needed to supply 33 kW is between 1,650 to 2,200 cells weighing from 104 kg to 139 kg.

| Energy | Cell | Cell Vol | Cell Wt | Cell E | # of | Wt | Density | Vol | Density |
|---|---|---|---|---|---|---|---|---|---|
| kWh | (d × l) | cm³ | grams | kWh | Cells | kg | Wh/kg | liter | kWh/L |
| 33 | 18650 | 21.06 | 46 | 12-8 | 2750-4125 | 127-190 | 260-173 | 58-87 | 0.57-0.38 |
| | 21700 | 30.87 | 63 | 20-15 | 1650-2200 | 104-139 | 317-237 | 51-68 | 0.65-0.49 |

Despite being cylindrical, the 18650 and 21700 volumes are calculated in the above table as rectangular prisms. This is because when packed together wasted space occurs in the gaps between the cylinders. For example, the volume of a 18650 cylinder Vol=(π(d/2)²|)=(π(0.9)²(6.5))=16.5 cm³. The volume of a corresponding rectangular prism of dimension d×d×l is given by Vol (rect)=(d²l)=((1.8)²)6.5)=21 cm³. The corresponding 3D dimensional packing efficiency is defined herein as

$$δ = \frac{Vo l ( cy1 )}{Vol ( rect )} = \frac{{π ( d / 2 )}^{2} I}{{( d )}^{2} I} = \frac{16.5 {cm}^{3}}{21 {cm}^{3}} = \frac{π}{4} = 78.5 \%$$

This means when packing cylindrical cells into a rectangular 3D array, 11.5% of the volume is wasted. The equation for 6 is therefore independent of the dimensions of the cylinder. The wasted volume however is not as

$$Δ Vol = Vol ( rect ) - Vol ( cyl ) = Vol ( rect ) ( 1 - δ ) = ( 11.5 \% ) Vol ( rect )$$

Since the volume of a rectangular prism containing an 18650 cell is 16.5 cm³, the wasted volume is 1.89 cm³ per cell. In an array of 2750 to 4125 cells described in the table, the unused volume in a 33 kWh battery array is therefore 5,198 cm³ to 7,796 cm³. By contrast the rectangular volume of a 21700 cell is 21 cm³, so the wasted volume is 2.42 cm³ per cell. In a 33 kWh array of to 2200 cells described in the table, the wasted volume ranges from 3,993 cm³ to 5,324 cm³. This means an 18650 battery pack comprises 5.2 to 7.8 liters (1.4 to 2.1 gallons) of unusable space while a 21700 wastes 3.9 to 5.3 liters (1 to 1.4 gallons) of volume. So the volume and weight of lithium ion battery packs to power a home for even one day is substantial. Unfortunately, at the present time, battery storage is the only option for businesses and homeowners who have already made an investment in solar power and now find recent and unwelcome changes in utility energy purchase policies renders their solar a losing proposition with no means to ever recover their investment.

The customers of utility of companies are not the only businesses that are seeking an efficient means for storing excess unused energy. Power providers have several reasons to deliver power to local sub-grids off peak hours and to store it locally.

Stored energy is referred to as secondary power. Secondary power and local storage offers numerous benefits. Firstly it reduces the ratio of peak power to average power carried by transmission lines comprising the power grid. When users demand more power, they are able to draw it from local storage rather than drawing it from the power plant. Secondly, local power storage provides a degree of redundancy in case the main grid suffers a brownout or a power failure. Lastly local power storage acts as a buffer minimizing line voltage perturbations caused by non-sinusoidal power sources such as renewables. Secondary power may be stored in a variety of forms, not necessarily only using battery storage.

### Secondary Power.

The storage of power for subsequent use is referred to a secondary power. Once generated from primary sources, energy may be stored as electric charge or converted into a form of potential energy in gaseous, gravitational, or chemical form. For example, primary power may be used to pump water to a large container at a higher altitude storing energy gravitationally. When needed, the water is allowed to fall from its container using gravity to accelerate the fluid into a steady stream. The falling water is then used to turn a turbine and AC generator to produce electricity in a manner similar to hydroelectric power.

Similarly primary power can be stored hydrostatically as a pressurized air for subsequent use. In this case a pump powered by a primary power source is used to compress air to store in a container at an elevated pressure, typically several hundred times that of normal atmospheric pressure. When needed, the compressed air is released at a control flow rate turning a turbine and generator to make electricity for use. For safety reasons, the highly compressed air is stored subterranean tanks away from residential areas. While both gravitational and pressurized gas can be used for local energy storage on a power grid, factory, building, or home, these forms of power storage are not portable. Less common energy retention and secondary power generation may employ temporarily stored energy comprising heat held in insulated containers or retained as momentum in large flywheels.

Another class of secondary power is chemical storage. In chemical storage, primary power can be used to separate chemicals into ions, reactive compounds, molecules, or elements. These components can be later converted into electrical power. The most common method of chemical energy storage is the use of an electrochemical cell known as a battery. In a battery reactive cations such as inorganic monovalent lithium ions are transported through the semipermeable separator propelled by an externally applied electric field. Delivered by a DC power supply called a charger, the applied electric field transfers power into the cell converting electrical energy into stored chemical energy. During charging, cations are transported across a semipermeable separator membrane accumulating on the anode electrode and increasing the cell voltage until the battery is fully charged. Once charged, the separator maintains the electrochemical potential between anode and cathode with minimal self-discharge leakage. The maximum stored charge and maximum cell voltage are limited. Exceeding this maximum voltage by overcharging may result in fire or explosion.

To recover power stored in the battery, an electrical load is connected across the cell's anode and cathode electrodes resulting in current flow in the battery, a process referred to as discharging. During discharge, electrons are removed from the anode flowing into the load. Concurrently, a corresponding number of cations must flow back across the separator to the cathode in order to maintain charge neutrality. This process discharges the battery lowering the electrochemical potential of the cell. In the case of lithium ion batteries, over-discharging of the cell may result in permanent cell damage subsequently leading to fire and possible explosion.

Another type of chemical storage is the process whereby electric power is used to form fuels or volatile chemical compounds to be used later for power generation. One such approach, called P2G or power-to-gas, employs electrolysis of water to produce hydrogen. The hydrogen may be used immediately to create electricity; stored in a pressurized canister for later use; or converted into another heavier fuel compounds such as syngas, methane, or liquid petroleum gas (LPG). These gasses may be stored, transported, and subsequently converted into electricity using conventional generators such as gas turbines.

Aside from electrolysis, hydrogen may also be produced from direct solar water splitting; thermochemical; and biological processes. Specifically during direct solar water splitting also known as photolytic conversion, hydrogen is produced from water using sunlight and specialized photoelectrochemical semiconductors. In direct photolytic conversion, absorbed light energy dissociates water molecules into hydrogen and oxygen. Alternatively, in photolytic biological systems, microorganisms such as cyanobacteria or green microalgae absorb sunlight as a driver to break down organic matter, releasing hydrogen. Thermochemical hydrogen production involves converting various fuel sources such as natural gas, biomass, or coal through a thermal process to release hydrogen from their molecular structure. Examples include natural gas reforming aka steam methane reforming, biomass gasification, biomass-derived liquid reforming, and solar thermochemical hydrogen. Biological hydrogen production includes microbial biomass conversion and photobiological conversion.

Beyond its use a fuel source for heating, hydrogen may be converted directly into electrical current using a hydrogen fuel cell with water as a byproduct of the chemical reaction. Although many different types of fuel cells are available for a wide range of applications, the most promising category of fuel cell is the proton-exchange-membrane or polymer-electrolyte-membrane fuel cell, with the acronym PEM FC. Well suited for portable and transportation applications, the PEM layer acts as an electrolyte to control proton transport after catalytically splitting hydrogen atoms into a hydrogen ion and an associated electron. A key requirement of the membrane is to allow proton conduction without allowing gas exchange of hydrogen and oxygen isolated in cathode and anode chambers.

Comparing the diversity of secondary power sources available today, the lithium ion battery and the PEM hydrogen fuel cell represent the best prospects for secondary power generation and energy storage, especially in transportation and portable applications. Each technology however suffers from a number of challenges including fire risk and safety considerations.

### Lithium Ion Battery Technology.

By far the most common form of energy storage involves the use of batteries. A battery is an electrochemical cell that once fabricated is able to absorb and retain energy through a process referred to as “charging” and to release the stored energy later to power an electrical load, a processes referred to as “discharging.” Despite their ubiquitous use, batteries suffer numerous limitations and intrinsic weaknesses, including the following:
After discharging, a battery must be recharged to a substantial charge state before reusing, a process which takes time during which an electrical vehicle cannot be driven, home battery backup power is lost, and electronics are inoperable or operate with diminished function.
Cycle life of a battery is reduced by repeated charge-discharge cycles where the total capacity at full charge diminishes over time. All batteries, even the popular Li-ion battery suffer limited cycle-life. Eventually the battery life becomes so limited the entire pack must be replaced, often at a price higher than the product using it.
Some batteries such as the lead-acid battery used in motor vehicles contain caustic chemicals or acids as an electrolyte representing a contact safety risk to users and first responders.
The manufacture of batteries includes hazardous, caustic, and flammable materials, especially chemistries involving group-I elements in the periodic table such as lithium. Factories have burned to the ground in Japan and in China from lithium fires.
Some batteries such as the Li-ion battery, contain highly volatile chemicals as electrolytes that if leaked from the cells or over-heated, may smolder, catch on fire, or in extreme circumstances explode. Reports of battery smoke and fire disabling vehicles such as aircraft, electric vehicles, notebook computers, and cell phones appear commonly in media publications. In extreme cases, battery fires may result in death or permanent burn injury.
Research on fire resistant cell construction using solid state lithium ion batteries, where the liquid electrolyte is replaced by a ceramic material continues. Although reported energy densities have improved, serious material and performance issues persist including high contact resistance between conductive electrodes and the ceramic electrolyte, and significant changes in battery characteristics when exposed to air and moisture.
To protect against accidental or intentional misuse of a battery, active protection electronics must be integrated into battery cells and into the battery pack system including protection electronics to prevent overcurrent, overvoltage, and over-heating and to maintain balanced cell voltages. Other protection mechanisms include a pressure release valve. In the event pressure builds up in the battery enclosure (metal can) containing the electrolyte from over heating, the battery vents the excess fumes to reduce the risk of explosion. Another protective feature is the use of a heterogeneous bi-layer separator that reduces or impedes current as a cell heats. This novel separator construction first developed in the 1980s includes pores which penetrate a separator of polymers or plastic layers having different coefficients of thermal expansion, i.e. dissimilar TCEs. While at room temperature, the pores align allowing the full degree of current to flow across the membrane, at elevated temperatures the pores misalign restricting ion flow thereby reducing heating.
Batteries are heavy relative to the amount of energy they store—performance measured by a parameter called gravimetric energy density, i.e. battery energy per weight. Cell weight is generally dominated by cobalt and nickel used in their construction of the battery cathode electrode followed by the graphite used in the anode in Li-ion batteries. The weight of the Li-ion battery pack in an electric vehicle can range from 450 kg to 900 kg (1,000 to 2,000 pounds) depending on vehicle's range. In a semi-truck, battery weight can exceeds 2000 kg, i.e. 2 tons. Although increasing a vehicle's battery capacity commensurately extends its per-charge driving range, the added weight unavoidably offsets the benefit of the additional storage. Moreover in commercial vehicles, battery weight reduces a trucks payload and shipping profit per load.
The manufacture of lithium ion batteries involves a significant adverse environmental impact in all phases of production including mining and extraction, purifying and processing, along with recycling and disposal. Effects include ground, air, and water pollution along with habitat destruction. Ground and water pollution includes heavy metals and toxins leaching into waterways and aquifers. Air pollution includes gaseous byproducts of chemical refining as well as CO₂ from mining equipment and electric power generation needed by battery factories.
Production of lithium ion batteries has a significant carbon footprint. The term CO₂e describes all the carbon released during the entire Li-ion battery production process where the subscript “e” denotes the term effective or equivalent estimated to be 73 kg CO₂e/kWh. This upfront consumption of energy used to mine and process raw materials and manufacture an EV battery pack means that a new electric vehicle starts at a carbon disadvantage compared to gas powered internal combustion engine, then makes up the initial deficit with each year of use. See discussion to follow.
The mining and production of lithium batteries has been criticized for their inhumane and unethical supply chain management including forced labor, child labor, and other forms of economic conscription of impoverished peoples. The United Nations and Amnesty International are seeking to combat the problem by attempting to pressure reform of the entire supply chain starting in the mines of the Democratic Republic of the Congo; in the cobalt smelters in China; in the battery manufacturers in China, Japan, and South Korea; and by promoting consumer awareness for change in the global consumer electronic and EV markets, especially in the USA, EU, and UK. Although Li-ion battery pack costs have declined significantly since 2008, coupling surging demand with improved pay and working conditions for those in the battery trade is expected to reverse this trend leading to increased battery costs. For now, the mining of metals for lithium ion batteries is considered the energy equivalent of blood diamonds, often mined in geopolitical conflict zones.
The raw materials used in lithium ion battery manufacture are concentrated in certain countries including China and Russia. As energy is considered a strategic component of national security by most countries, the supply chain for sourcing ores and salts used in lithium ion production now carries geopolitical considerations.

A key application of the lithium ion battery is in electric vehicles or EVs. To fully assess the environmental benefit of a battery EV we must consider the total green house gasses emitted during both manufacturing and use. Of the 73 kg CO₂e/kWh total carbon dioxide produced during battery manufacturing, roughly 40% or 28.5 kg CO₂/kWh occurs during mining, conversion and refining of the nickel-cobalt-manganese NCM powder. The second most energy-demanding activity, cell production, requires 14 kg CO₂/kWh or 20% to power drying and heating in the manufacturing process. The third largest impact on greenhouse gasses is aluminum refining. An intrinsically energy intensive process, aluminum production is responsible for 12.4 kg CO₂/kWh or 17%. Another 6.8% is used to fabricate associated pack electronics with an added 5% consumed in producing the battery's graphite anode. The high carbon footprint is largely tied to the fact that China, a major battery producer derives 60% of its electric power from coal. Given a 73 kg CO₂e/kWh dependence of released carbon during manufacturing, the net carbon footprint for a eV battery with a range of 40 kWh (e.g. Nissan Leaf) is 2920 kg, while a 100 kWh (e.g. Tesla) requires 7300 kg of CO₂.

Unlike internal combustion engines which burn gasoline and release CO₂ and other pollutants, greenhouse gasses from an EV come not from the vehicle itself but from the power production needed to charge the EV battery. As a reference, the US DoE reports conventional gasoline fueled engines emit 2.4 kg CO₂e for every 10 km travelled. In contrast, studies report EVs emit 1.0±0.5 kg of CO₂e, i.e. from 5-to-15 kg per every 10 km travelled, depending on how and where the electricity used to charge the EV battery is produced. This means the beneficial reduction in CO₂ emissions ranges from 0.9-to-1.9 kg for every 10 km driven with a nominal saving of 1.4 kg for typical electrical grids used for charging. For an average driving distance of 25,000 km (15,500 miles) per annum, a combustion engine releases 6,000 kg (6 metric tons) of CO₂ while an EV emits 2,500 kg or 2.5 metric tons.

This means an EV reduces carbon emissions by 3,500 kg (3.5 metric tons) per annum per driver with a net savings of 60%. Considering as described previously, an EV's initial carbon footprint is 4-to-7 metric tons larger than a gasoline engine at manufacture, and that EVs save 3.5 metric tons of CO₂e per annum, it means the break even point where an EV becomes “greener” than a gasoline engine occurs between 1-to-2 years of use. After 5 years use, a gasoline engine has released 30 metric tons of carbon dioxide while an EV has emitted an average of (5.5+5.1)=10.5 metric tons including the 5.5 metric ton initial offset due to battery manufacturing pollution. As such, over the lifetime of the car, an EV reduces greenhouse emissions by two-thirds.

Unfortunately, the ecological damage of mining and high volume manufacturing of Li-ion batteries cannot be measured by CO₂ emissions alone. As such, efforts continue to find viable alternatives to the ubiquitous Li-ion battery.

The dynamic or time-dependent behavior of lithium ion cells involves the flow of electrons in a battery circuit and corresponding changes in the electrochemical and states within the cell corresponding to conduction. Normally, batteries alternate in three states of operation:
Charging: Conducting current in response to an external circuit comprising an electrical source power which increases the charge Q stored in the electrochemical cell, i.e. converting kinetic electrical energy into chemically stored potential energy.
Discharging: Conducting current in response to an external circuit comprising an electrical load which decreases the charge Q stored in the electrochemical cell, i.e. converting chemically stored potential energy into kinetic electrical energy.
Storage: The condition when a battery is electrically disconnected from any external electrical circuit whereby the charge Q stored in the electrochemical cell and the electrochemical potential therein does not change over time except for small changes in the internal electrochemical charge state within the battery itself (known as self-discharge).

In general, current in a battery varies as a function of time, i.e. I=f(t). Time variations in cell currents occur because most electrical networks to which a batteries are connected exhibit both transient and oscillatory properties, depending on operating mode of the system. These conditions arise when a battery is connected or disconnected to a power source (such as an AC-to-DC adapter), when an electrical device (like a cell phone) is turned on, or when the supply or demand of current in the battery naturally has time varying or reactive components. The same energy delivery requirements arise when driving an electrical load directly from a fuel cell. The internal resistance of conventional fuel cells available today, however, greatly limit their electrical performance. Operation of lithium ion battery alternates between two modes—charging and discharging.

Charging is achieved by connecting the positive terminal of a power source to the positive (cathode) terminal of Li-ion cell allowing conventional current I_{charge} to flow clockwise from the power source into the cathode of the battery. By definition, electron conduction e⁻ in the circuit's conductors flow in opposite direction, i.e. counter-clockwise.

Conversely, discharging is achieved by connecting an electrical load (often depicted as a resistor) across the positive (cathode) to the negative (anode) terminals of Li-ion cell allowing conventional current I_{discharge} to flow from the power source emanating from the cathode of the battery and dissipating power in electrical load. By definition, electron conduction e⁻ in the circuit's conductors flow in opposite direction.

The charging and discharging processes can be better understood by considering the electrochemistry of a lithium ion cells. More precisely, the cells themselves follow the same basic electrochemistry of a coupled redox reaction comprising concurrent oxidation and reduction in opposite halves of the cell. The lithium ion battery comprises two electrodes of differing composition called an anode and a cathode sharing a common enclosure and immersed in a conductive liquid or gel called an electrolyte. The anode connects to external circuitry through a conductor referred to as the anode electrode while the cathode connects to external circuitry through its conductive cathode electrode.

To limit the reactions to electrochemical ion exchanges, and not to purely chemical processes, the two cell halves are separated by a porous membrane called a separator. The separator, often made of a polymer sheet, contains pores large enough to allow lithium ions to flow from chamber to chamber during charging or discharging. The pores are however sufficiently small as to prevent molecular transport across the barrier (except in the event of a tear or melting on separator, a destructive and potentially dangerous failure mode).

During discharge, current I_{discharge} flows from the cell and through the load, dissipating some of its energy as heat in the load and generating heat in any parasitic resistive elements in the cell. The chemical reaction occurring during discharge is exothermic, producing additional heat not related to Joule heating in the metallic electrodes. The actual direction of current flow in battery often confuses many people. Following conventional electrical notation, during discharging positive charges flow internally with the electrochemical cell from the anode and flow externally from the cathode (labelled with a +sign) to the anode (labelled by a −sign) to form a single continuous loop of current. While it is true that ionized lithium atoms comprise positively charged Li⁺ ions, the lithium ions never leave the battery, instead forming lithium oxide complexes within the cathode. But since metallic electrodes and copper wires do not contain mobile positive charges, how can positive current flow in them? The simple answer is it doesn't.

Instead conduction in metals is limited to electron flow (denoted by e⁻) in equal amount but opposite in direction to the current flow convention. That means during discharging, current external to the battery flows from the battery's negative anode terminal toward the battery's positive cathode terminal in the form of electrons, not positive charge. But Kirchhoff's current law, a variation of charge conservation, states that the total current flowing into a node must always equal zero, expressed algebraically as

$${\sum }_{k = 1}^{n} {I}_{k} = 0$$

This means positive charging flowing into the cathode must equal positive charge flow out. But another way to interpret the meaning of positive charge flowing out is to consider the current as negative charge (aka electrons) flowing into the node. Charge conservation states that since charges are neither created or destroyed the total charges must balance to a net zero. The manifestation of the charge conservation principle become self evident by inspection of the electrochemical reaction at the cathode for a lithium ion battery given by

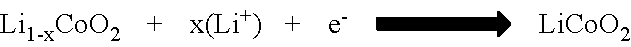

where a lithium metallic cathode comprising Li₁₋ₓCoO₂ is converted to LiCoO₂ by absorbing both positive charged lithium ions x(Li⁺) and an electron e⁻. During the reaction the lithium ions are supplied to the cathode by charge transport across the separator and through the electrolyte while the electron is donated from the wire carrying negative charges into the battery's cathode terminal.

Concurrently at the carbon-lithium anode C(Liₓ) electrons e⁻ are released into the wire and lithium ions x(Li⁺) are released into the electrolyte, where C is the chemical symbol for elemental carbon:

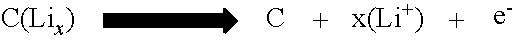

thereby balancing the charges in the cell to a net zero change. Since the charges balance to zero, in doesn't matter that charge transport involves two different mechanisms—positive charge flow (lithium ions) inside the cells and electron flow outside the battery. Regardless the magnitude of current conduction in the loop (measured by coulombs per second, i.e. milli-amperes) is the same in the wire, the resistor, or the cell.

Therefore, the arbitrary adoption of positive charge flow as the standard definition of conventional current conduction offers the same mathematical precision and utility as a more detailed physics based mechanistic description but without the added complexity. Regardless, semiconductor physicists and battery chemists often casually intermix the current and electron flow terms without identifying the charge polarity or flow direction as it is self evident to those in the art.

In summary, during discharge a lithium battery changes stored energy into conduction current by converting C(Liₓ) into C at the anode and concurrently changing the metallic (Li₁₋ₓ)CoO₂ into LiCoO₂ at the cathode. Since these compounds are in limited supply, the total charge Q available to power an electrical load by discharging the electrochemical cell is finite as given by the relation:

$$Q = {\int }_{o}^{t} I dt$$

While physicists measure charge in Coulombs (symbol Q), in battery powered electronics it is more useful to report a battery's capacity in milliamp-hours (mAh) or ratiometrically as C-rate where 1 mAh=3.6 coulombs. Care should be taken not to confuse the chemical symbol C meaning elemental carbon in chemical reactions with its use as the symbol C meaning coulombs, and also with its use as capacitance (where C is both a mathematical variable and a schematic element label). Theoretically, charging a lithium ion cell should induce chemical reactions precisely the inverse to discharging, where during charging the anode must absorb electrons according to the reaction

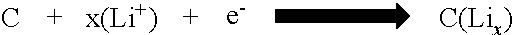

During charging electrons are supplied by a power source having its positive terminal connected to the battery's cathode (+ terminal) and its negative terminal connected to the battery's anode (− terminal). Concurrently during charging lithium ions flow inside the cell through the electrolyte and across the separator between the cathode and anode. The resulting reaction at the cathode during charging comprises

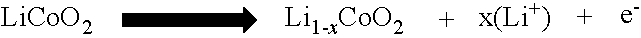

The thermodynamics of charging in endothermic, i.e. electrochemically the cell absorbs heat from its surroundings becomes cooler in temperature. This cooling effect is however offset by Joule heating in the electrodes carrying the charging current. In general, for a healthy Li-ion cell charging occur at a cooler temperature than discharging. Since the charging equations mirror the discharging equations, meaning the products and reactants are swapped (i.e. the arrow direction is flipped), then charging and discharging of a lithium ion battery represent a reversible electrochemical reaction. Because however, the thermodynamics of these two operating modes differ, the charging and discharging reactions occur at different rates and at different temperatures.

In both charging and discharging the amount of current flowing varies with time depending on load or power source connected to Li-ion cell, the construction of the battery and its capacity, and the cell's age. A battery's age is not simply measured in calendar years, but by cycle-life, the number of times the cells are repeatedly charged and discharged.

If the electrochemical reactions described previously were truly reversible a battery's cycle life would be unlimited, at least until its metallic electrodes corroded. But because the reactions are not purely symmetric, small changes in a cell's stoichiometry occurring within each charge-discharge cycle results in small but irrevocable changes in electrochemistry, even if electrical operation is limited to the manufacturer's specified operating conditions. Conditions affecting battery cycle life include rate of charging, discharging currents including surge currents, temperature during charging, temperature during discharging, depth of discharge, storage conditions, and state-of-charge (SoC) during storage.

To depict and model the electrical behavior of the cell, it is common to used a schematic referred to as a lumped element circuit model. In a lumped element model, electrical behavior are combined into simple elements such as resistors, capacitors, and voltage sources even though the physical mechanisms are distributed throughout the cell or over distance. Phenomena like polarization may also be modelled as a counterposing electrical potential offsetting a fixed potential even though it is describing voltage variations of an electrochemical process.

In electrical engineering it is important to note that an electrical model is indeed a mathematical model of physical phenomena but not an accurate representation of the actual physical or chemical processes responsible for the current-voltage characteristics. Simplified electrical models for a Li-ion battery combine two time-invariant elements with two dynamically-changing components, namely two voltage sources and two resistive elements. Specifically the energy stored electrochemically can be represented as a constant independent voltage source with an open-circuit voltage V_{OCV}. A lumped element resistor, also time invariant, models the series resistance of the electrodes within the cell having a lumped resistance value R_{ohmic}.

The other two components are dynamic including cell polarization voltage source exhibiting time and frequency dependent voltage Vₚ(t) and dynamic cell polarization resistance with an aggregate distributed resistance R_{cells} (t). Together these two time-and-frequency sensitive elements appear as a dynamic impedance Z(t) shown for a lithium ion battery. The terminal voltage V_{bat} of the single Li-ion cell as a function of current is then given by the relation

$${V}_{bat} = {V}_{OCV} - {V}_{P} - I \cdot \{ {R}_{cells} + {R}_{ohmic} )$$

where −V_{P}−I·(R_{cells}) represents a dynamic (i.e. time-dependent) voltage drop affected by frequency and I(t). The total non-reactive component of resistance R_{bat} is therefore the real component of impedance Z(t) as given by R_{bat}=(R_{cells}+R_{ohmic}). All of these components both real and reactive depend strongly on the cell's state of charge (SoC) a description of the ratio of the current cell charge Q (above the minimum charge Qₘᵢₙ) divided by the cell's full capacity charge Q_{capacity} where

$$SoC = ( Q - {Q}_{min} ) / {Q}_{capacity}$$

where Q_{capacity}=Qₘₐₓ−Qₘᵢₙ. For cases where Qₘᵢₙ<<Qₘₐₓ then

$$SoC = ( Q - {Q}_{min} ) / {Q}_{capacity} \to / {Q}_{max}$$

For example, a 2,500 mAh capacity cell holding 1,000 mAh of residual charge has a SoC of 40%. The open circuit voltage of lithium ion electrochemistry V_{OCV} varies from 3.2V-to-4.1V depending on the cell's SoC and chemistry. While some Li-ion cells exhibit a peak SoC voltage of 4.1V or 4.2V other chemistries employing different cathode metals only reach 3.6V-to-3.7V. The polarization voltage V_{P} 45 shown in the same graph on the rightmost y-axis remains relatively constant at 30 mV until SOC drops below 10%, then rises sharply to 160 mV indicating cell chemistry changes significantly when deeply discharged.

State-of-charge (SoC) also impacts a Li-ion cell's ohmic resistance R_{ohmic}. For example the ohmic resistance during charging may remain a constant 3.5 mΩ until the cell's SoC falls below 40%. At this point the resistance rises linearly to 3.9 mΩ at 10% then jumps 41% to 5.5 mΩ. The effect of SoC on ohmic resistance during discharge is even more pronounced than during charging, with R_{ohmic} exceeding 4.5 mΩ below 40% and doubling in resistance at 25%. This means the surge current capability is halved when a cell is discharged below a quarter of its rating.

A Li-ion cell's open circuit voltage V_{OCV}, also referred to as its cathode voltage, depends on the construction and composition of its electrolyte and electrodes. For example a LiFePO₄ based cell fully charged to 3.5V achieves gravimetric energy densities up to 140 mAh/g. In contrast LiNi_{0.8}Co_{0.2}O₂ based chemistries exhibit voltages of 3.7V but when charged to higher energy densities of 200 mA/g increases to 4.2V. Energy densities also depend on crystalline structure. LiCo₂ and NMC with (111) crystal orientation both exhibit voltages between 4.0V and 4.2V while LiMn₂O₄ displays the highest voltage at 4.25V d=corresponding to energy densities of 120 mAh/g.

Charging above these voltages can lead to catastrophic cell damage, overheating, smoke and fire. But since the voltage at full charge varies by cell chemistry, there is no way to design protection circuitry to prevent dangerous overvoltage conditions on all cell types. For example, protection for LiCo₂ cell at 4.2V cannot prevent fire for LiFePO₄ whose maximum safe voltage is 3.5V. For these safety risks, Li-ion cells cannot be sold and used in loose form like NiCd, NiMH, and alkaline batteries. Instead, each Li-ion cell must be assembled into a “battery pack” containing the cell and its corresponding protection circuitry.

The protection circuitry is designed to avoid a variety of failure modes including overvoltage, undervoltage, overcurrent, over-temperature, etc. In this sense, the safe use of Li-ion cells, both during charging and discharging is neither simple nor obvious as it depends on cell chemistry, material selection, and cell construction.

Since batteries vary by size and storage capacity, when comparing charging and discharging properties of cells it is convenient to use stored charge rather than current. If we consider the charge contained within a battery as charge Q measured in coulombs denoted by the capital letter C and that Q=(l·t) where I measured as amperes is defined as 1 A≡1 C/sec, then it follows logically a coulomb may also be expressed in terms of ampere-hours simply by adjusting time t by the conversion factor that 1 hour=3600 secs. When expressing Q not as coulombs, but in units of Ah (also written as A-hr, mA-hr, or mAh) then current can be designated by the term “C-rate” algebraically represented as

$$C - rate = {Q}_{capa ity} / t$$

As such, the C-rate of a battery is the total charge capacity of the battery (measured in mAh) normalized by time (in hours). For example, at a C-rate of 1 C a battery having Q_{capacity}=1,000 mAh battery will deliver 1,000 mA for one hour. At a C-rate of 2 C the same battery can deliver 2000 mA for 0.5 hours. Similarly, at a C-rate of 0.5 C, a battery can deliver 500 mA for 2 hours, a C-rate of 0.2 C can deliver 200 mA for 5 hours, and a C-rate of 0.1 C can deliver 100 mA for 10 hours. Reformulating the prior C-rate equation

$${Q}_{capa ity} = t \cdot C - rate$$

the hyperbolic relationship between C-rate and time becomes self-evident whereby discharge time is inversely proportional to C-rate with the constant of proportionality being the battery's charge storage capacity Q_{capacity}.

The advantage of describing battery capacity by C-rate is that it scales with current, making it convenient to determine how quickly a particular battery takes to charge or discharge as a ratio of current to its capacity. Since in physics charge is a conserved quantity, then C-rate can be considered a path independent ‘state variable’ valid regardless of whether current is constant or time varying. This is important because Li-ion and many other battery chemistries must operate in a specified range of charge states designated as Qₘᵢₙ and Qₘₐₓ. Charging the cell above Qₘₐₓ or discharging it below Qₘᵢₙ can lead to cell damage and potentially cause overheating, fire, or explosion.

Discharging at a C-rate of 1 C will discharge a battery from its maximum stored-charge level of (Qₘᵢₙ+Q_{capacity}) to a minimum level of stored charge Qₘᵢₙ in a duration of 1 hour. The removal of the stored charge Q_{capacity} can involve any discharge waveform comprising time varying load currents I (t) whereby

$${Q}_{capacity} = {\int }_{0}^{t} I ( t ) dt$$

which can be expressed as an average current Iₐᵥₑ conducted over the discharge interval t where to fully discharge a battery

$${I}_{ave} = {Q}_{capacity} / t$$

Ideally, the equation is symmetric for both discharging and charging, where a charging current of 1 C shown increases the charge on the battery after 1 hour from Qₘᵢₙ to Qₘₐₓ where Qₘₐₓ=(Qₘᵢₙ+Q_{capacity}). Charging at a smaller C-rate of 0.5 C is slower, requiring 2 hours to increase the state of charge to 100%.

To avoid overcharging a cell, electronic protection must either monitor the charge charges in the cell, a process called coulomb counting, or precisely control the maximum and minimum cell voltages to stay within the safe operating area of SOA. Using voltage to define the safe operating area or SOA of a lithium ion battery the safe operating voltage range is bounded between maximum safe voltage called the overcharge voltage V_{OC} and the lowest safe voltage, the over-discharge voltage V_{ODC}. Operating in an over-discharged battery condition may permanently damage the cell reducing is capacity and possibly impeding normal charging.

Commencing charging in the over discharged state must be performed carefully to avoid battery malfunction, permanent damage, or worse. One such method is to use low charging currents (sometime called trickle charging) when operating below V_{ODC}. Whether damage actually occurs to the Li-ion battery depends on many variables leading to the battery's discharging including temperature, depth-of-discharge, the discharging current, and storage time.

Overvoltage conditions in a Li-ion battery are far less forgiving. Even slight overcharging a Li-ion battery above V_{OC} can lead to severe consequences including overheating during charging and potentially an explosion at only a slightly higher voltage. The actual voltage varies by each lithium battery chemistry. The voltage difference between the top of the safe operating area and the edge of fire risk condition can be as little as 50 mV, so extreme care must be taken to avoid overcharging using voltage as a control parameter.

Importantly, the process of Li-ion battery charging is not performed by simply applying a fixed voltage to the cell until the charging current decays but involves two different modes, constant current (CC) charging and constant voltage (CV) charging. Moreover, charging currents may be controlled using continuous DC current or by employing pulse modulation and duty factor control to reduce heating. In general, pulsed charging is capable of faster charge times than continuous charging. Other benefits of pulsed charging include extended battery cycle life.

Safe operating area is however, not only defined by voltage but also by current and temperature. Excessive charging or discharging currents can cause rapid heating leading to cell damage and fire risk. Protection circuitry is thereby required to prevent cell damage from operating outside the specified SOA for all four key parameters—overcharge voltage (V_{OC}) limit, over-discharge voltage (V_{ODC}) limit, over-current restrictions during charging and discharging, and an over-temperature protection (OTP) limit.

Although Li-ion operation is strictly interrupted in event of exceeding overcharge voltage (V_{OC}) limit or dropping below over-discharge voltage (V_{ODC}) limit, limitations in the safe operating range of current must be managed in a completely different way. A simple overcurrent detection circuit shutting off conduction above a defined level is not possible because of inrush current occurring when an electrical load is first connected to the battery as discussed previously in this application.

If such a strict protective measure would be included in a battery pack, the overcurrent protection would falsely trip from inrush every time the battery is connected to a load, rendering the battery totally useless. Instead Li-ion batteries are manufactured to accommodate much higher currents than the specified ratings of the product sold both during charging and during discharging. The manufacturing involves testing to ensure the fabricated cell is not defective and able to handle transient currents substantially higher than the cell's steady-state current rating.

For example during charging, a cell is rated to charge at a maximum charging current I_{chrg(max)} 60 at a specified C-rate of +1 C. In order to ensure safe and reliable charging within the specified range, during manufacturing the cell is tested for safety at a charge current I_{chrg(test)} at a C-rate of 2.5 C, more than 2.5-times the cell's rating. If the Li-ion cell is assembled into a battery pack prior to testing, then any overcurrent protection device must be chosen to trip at a level slightly exceeding the tested charge current I_{chrg(test)} to avoid falsely triggering the protection mechanism during test charging. If, however, the cell is tested without any protection electronics, then the overcurrent protection device can be selected to trip at a level slightly below the tested charge current I_{chrg(test)}.

Note that the average charge current I_{chrg(CC)} during constant-current mode charging is lower than specified current I_{chrg(max)} which in turn is less than test current I_{chrg(test)}, where I_{chrg(CC)}<I_{chrg(max)}<I_{chrg(test)} is maintained. This guard band is deceptive as the constant-current vale I_{chrg(CC)} is an average value. If pulsed charging is used, the peak current for a 50% duty factor charging profile may be double the average current I_{chrg(cc)}, clearly beyond I_{chrg(max)} but still below I_{chrg(test)}. At 33% duty factor the peak current is triple the average

The current guard band required for battery discharging is far more liberal than for charging. Unlike charging circuitry selected by a product system specifier, discharge current is determined by the electrical load which cannot be predicted, especially during load transients, inrush, and start-up conditions. For example, a cell rated to carry a maximum steady-state discharge current [−I_{load(max)}] at a specified C-rate of −2 C may be tested at a peak discharge current [−I_{load(test)}] at a predefined C-rate of −13.5 C, a current nearly seven-times the recommended maximum discharge value [−I_{load(max)}]. If over-current protective circuitry for battery discharging is included in battery pack it is normally included primarily for short circuit protection, and not to limit short duration current spikes. As such, the overcurrent shutdown threshold [−I_{OCSD}] is selected to be even greater in magnitude than [−I_{load(test)}]. For load currents greater in magnitude than [−I_{load(test)}] but less than [−I_{OCSD}], battery packs typically rely on over-temperature protection (OTP) to prevent safety hazards rather than over-current detection circuitry.

For this reason, some packs specify a 1 second, 3 second, or 10 second current rating to accommodate inrush and startup current requirements for various loads. Capacitive and motor loads exhibit the greatest inrush currents whereas resistive and inductive loads are more benign. That's said, an electrical load comprising a push pull ‘half bridge’ can exhibit extremely high dI/dt and dV/dt transient rates in a process referred to a forced diode recovery which does not involve current flowing power supply but by energy stored in an inductor, the details of which are beyond the scope of this application.

As described, the charging and discharging currents are not listed in terms of amperes but specified as C-rate. The actual current values thereby scale in accordance with the capacity of the battery. For example the actual current for a 2 C discharge rate using a 3,000 mAh battery is 6 A while a 2 C discharge rate using a 1,000 mAh battery is only 2A, one third the current. Similarly a 1 C charge rate charges for a 3,000 mAh battery comprises a 3 A charge current while a 1,000 mAh battery requires only 1 A.

Regardless of the battery capacity, the ratio of the rated discharge current to the rated charge current is two-to-one. The ratio of test current defining the SOA to the rated current varies significantly between charging and discharging conditions. While charging, the peak test current is only 2.5× the operating range, during discharging the ratio is 6.75. This asymmetry between charging and discharging is illustrated in the table below listing the SOA ratings for a differently rated Li-ion batteries.

| Cell capacity, | 1000 | mAh | 3000 | mAh |
|---|---|---|---|---|
| coulomb equivalency | | | | |
| Charge current | 700 | mA (0.7 C) | 2.1 | A (0.7 C) |
| I_{chrg(CC)}, typical | | | | |
| (average) | | | | |
| Charge current | 1 | A | 3 | A |
| I_{chrg(max)}, 1 C rated | | | | |
| Charge current | 2.5 | A | 7 | A |
| I_{chrg(test)}, 2.5 C rated | | | | |
| Discharge current | −2 | A | −6 | A |
| I_{load(max)}, 2 C rated | | | | |
| Discharge current | −13.5 | A | −40.5 | A |
| I_{load(test)}, 13.5 C rated | | | | |
| Cell resistance | 12 | mΩ | 4 | mΩ |
| Short circuit current, | 350 | A (350 C) | 1050 | A (350 C) |
| 0 Ω, 4.2 V full charge | | | | |
| Overtemperature | 72−to−90° | C. | 72−to−90° | C. |
| shutdown | | | | |

One key property of the lithium ion battery is its ability to deliver high currents on demand to an electrical load. For a 3,000 mAh battery, a 13.5 C test current is an impressive 40.5 amperes. Although this current is quite substantial, it is no where near the peak current capability of a lithium ion cell. In this regard, the peak cell current defined as the short circuit current I_{sc} is given by the relation

$${I}_{SC} = \frac{{V}_{OC}}{{R}_{bat} + {R}_{short}} \leq \frac{4.2 V}{{R}_{ohmic}}$$

where V_{bat}=V_{oc}=4.2V, Rₛₕₒᵣₜ=0, and R_{bat}≈R_{ohmic}. For a standard 18650 cell, R_{ohmic}=4 mΩ in which case I_{sc}=1050 A, or a C-rate of 350 C. The ratio of the short circuit current to the discharge test current is given by I_{SC}/I_{load(test)}=350 C/17.5 C=20×. This large ratio enables short circuit protection to be set at an intermediate value without limiting the transient current performance of the battery. Protection for high discharge currents of extended duration instead rely on overtemperature protection in the range 72-to-90° C.

Despite its high energy density capability one concern with cylindrical Li-ion cells is internal heating, especially in the event of an operational fault or a battery pack malfunction. For this reason batteries must include an over-temperature shutdown circuit which detects temperature and shuts off conduction whenever the temperature exceed the shutdown limit T_{OTSD}.

Should excess heat generation from changing electrical conditions exceed a safe temperature, without properly functioning temperature protection the temperature can run away, rising uncontrollably until cell destruction or a fire occurs. Because of its cylindrical construction heat in the Li-ion cell concentrates in the center of the cell having a radial temperature distribution and centered lengthwise. The cell centric concentration in heat causes the electrolyte to expends creating internal pressure which can cause the cell's metal can to burst in the center or explode. Another possibility is internal pressure causes the electrolyte to leak around chemical seal and potentially combust in the presence of oxygen.

Because the fire risk is very real, the protection of lithium batteries is and continues to be a key concern in their widespread and ubiquitous use. Despite the numerous precautions detailed in this whitepaper, numerous inexplicable failures and fires persist. More effort is required to identify the root cause of such application failures and prevent further incidents.

Because of its low series resistance and high load transient current capability during discharge, the lithium ion battery is capable of supporting a wide range of applications. Conversely, given its extreme sensitivity to overvoltage and to the risk of cell damage from over-discharging, care must be maintained to ensure operation within its safe operating area (SOA). Described previously, as a highly energetic electrochemical reaction, operating a Li-ion cell beyond its voltage-current-temperature SOA risks overheating, electrolyte leakage, smoke, ignition, fire, and possibly explosion.

To maintain operation strictly within its SOA, lithium ion battery packs employ a battery disconnect switch or “BDS” as a protective device separating the packs cells from electrical loads or power sources external to the pack, disconnecting them whenever a fault condition arises. While protection against excessive voltages, temperatures, and short circuits can be monitored using voltage references and comparators, the process of charging is more complex. During charging, high currents of extended duration can lead to elevated internal cell temperatures causing degradation of the battery separator, changes in electrolyte stoichiometry, electrode corrosion, and premature aging. Unfortunately lowering battery charging current results in excessively long charging times.

Rather than by supplying continuous conduction, in alternative approach pulse charging delivers short repeated bursts of high-currents to maximize the average charging rate while minimizing internal heating. So although pulse mode charging is able to control the average power transferred from a power source to the battery and thereby control heating, pulse mode operation does not limit the peak current in the battery during the conducting portion of the cycle.

Specifically, most step-down switch-mode battery chargers employ a Buck converter topology, one where the input to the charger Vᵢₙ is momentarily connected by a low-resistance conducting switch such as a power MOSFET to one terminal of an inductor. The other side of the inductor is connected to the converter's output, in this case the battery at a voltage V_{bat}. During each conducting interval the inductor instantaneously supports a voltage V_{L} equal to the differential voltage of its input and output, i.e. ΔV=(Vᵢₙ−V_{bat}). During inductor conduction, the current-voltage relationship is governed by the fundamental branch constraint V_{L}=L (dI/dt) where V_{L}=ΔV=(Vᵢₙ−V_{bat}).

Accordingly, the larger the voltage difference (Vᵢₙ−V_{bat}) across the inductor, the faster the current ramp dI/dt, the higher the peak current will be. Unfortunately, high current spikes, even of brief duration can still damage a lithium ion cell. This limitation is problematic when a Li-ion battery is deeply discharged, i.e. with a low state-of-charge SoC when current pulses are high, diminishing as the battery voltage rises.

The solution to this challenge is a dual-mode charger comprising a linear-mode constant current charger, a switching charger, and a mode select mechanism depicted as a SPDT single-pole double-throw switch. In operation, whenever the voltage differential ΔV=(Vᵢₙ−V_{bat}) is large, i.e. in deep discharge, the linear charger delivers a constant current to the battery, denoted by the descriptor CI or sometimes CC. During CI charging, the battery reaches a specific target voltage at time t_{CV} the charger mode select circuit switches from CI constant current mode to CV constant voltage mode and switching charger becomes active. CV charger mode offers at least three advantages over CI mode. First, it charges the Li-ion cells faster than CI mode. Secondly switch mode operation is more energy efficient than linear mode. In linear mode a voltage is sustained across the control device whilst current is conducted.

Thirdly and foremost, CV mode will not exceed the maximum safe voltage of the lithium ion battery pack. In CV mode, charging current drops to zero as the target voltage for V_{bat} is approached. In this manner CV mode has no risk of overcharging the cell or exceeding its overcharge voltage. It should also be noted that lithium ion chargers, even dual-mode, require and assume a stiff voltage source as their input. In conventional chargers, if the input power source is unable to deliver the requisite power and current, charger operation will fail. This means lithium ion pack charging from a PV array, wind turbines, and from fuel cells are not trivial. Instead, most Li-ion packs are charged from the AC mains or with the assistance of the grid in case a cloud passes over the PV at the wrong time.

Like any battery, however, the Li-ion cell requires time to charge. This is particularly problematic in electric vehicle applications when a driver must interrupt travel to recharge. Battery charging is problematic for long journeys as it adds to travel time and driver fatigue. The availability of charging stations is another concern, especially in extremely cold weather where a car failure can be deadly. High global demand for high capacity lithium ion packs is another problem, facing supply chain challenges in scaling up Li-ion production, including unethical labor practices and the ecological impact of mining of cobalt, lithium, and other minerals needed in lithium ion battery pack assembly. Despite the foregoing issues, Li-ion battery represents the today's only viable technology for portable power in electronics and electric vehicles. The question persists what role if any can hydrogen fuel cells play in the future of power generation, distribution, and energy storage.

Given a practical limitation in the peak C-rate of Li-ion cells, the fastest way to charge a lithium ion cell is to disconnect all electrical loads during charging to expedite its electrochemical charging process. In an EV, dedicated charging means a driver must interrupt travel while recharging their car. If a public charge station can only deliver a charge rate of 0.5 C, it means recharging could take two-or-more hours turning a manageable four hour trip into arduous six hour ordeal. Moreover, there may be a line of several cars waiting to charge at a charging station, a situation extremely frustrating for long-distance travelers on their sojourn.

Other battery chemistries currently in development include lithium polymer, metal-hydrides like NiMH, sodium ion, zinc air, solid state lithium, iron air, and LFP lithium iron phosphate. Lead acid cells are generally considered too heavy and caustic for most applications. While some of these chemistries hold promise it is projected they will take years or even decades to perfect and even longer to scale for volume manufacturing. In fact if hypothetically an ideal battery chemistry were to be discovered, commercially deploying the technology including testing, certification, installing production capacity, ramping the factories, and installing the new chemistry will require a minimum of ten to fifteen years. Anything under ten years is unheard of, especially in transportation markets.

In summary the advantages and disadvantages of lithium ion batteries are summarized in the following table:

| Li-ion Battery Advantages | Li-ion Battery Disadvantages |
|---|---|
| High current, low resistance | Cannot generate power |
| High on-demand power | Requires charging, takes |
| capability | time to charge |
| Pluggable, able to charge | Limited kWh capacity |
| from charger station | per charge |
| Energy recovery capable | Heavy weight, poor gravimetric |
| (regenerative braking) | energy density |
| Humidity insensitive | Limited BEV driving range |
| Wide temp range, cold | Central packs single-point |
| temperature operation | failure system risk |
| Limited cycle life | Requires safety circuitry |

### Hydrogen Fuel Cells

Today the only realistic alternative to a lithium ion battery for portable energy and transportation is hydrogen fuel cell technology using hydrogen as a transportable source of power. Although a fuel cell may be considered as an energy generator rather than a form of energy storage, it does not truly represent a primary power source as it requires fuel, specifically hydrogen, to operate. This hydrogen must be extracted from another source, molecules containing hydrogen before a fuel cell can function. Common hydrogen sources include water, natural gas, methane, and other fossil fuels. The hydrogen once produced is then converted into electricity by the fuel cell through an electrochemical process whose only byproduct is water, giving the appearance that a fuel cell is a pure pollution-free source of green electrical energy. But are hydrogen fuel cells really a source of clean energy? As the old adage goes—“the devil's in the details.” The key point is pure hydrogen does not naturally occur in nature (except in rare cases), but instead like many other sources of usable energy must first be extracted, i.e. refined.

### Making Hydrogen.

The process of hydrogen extraction however requires energy from a primary energy source, generally electricity generated from fossil fuels, natural gas, nuclear power, hydroelectric power, or from renewables such as solar energy and wind power. The pollution caused by a hydrogen fuel cell is therefore not the process of converting hydrogen into electric current, but the pollution and carbon gasses emitted during the production of its hydrogen fuel or producing the energy used to power the hydrogen production process.

Accordingly, how “green” a hydrogen fuel cell depends on how polluting the power is to make its hydrogen production in the first place. Pollution emitted from hydrogen production is commonly referred to in accordance with the hydrogen color spectrum (even though it has nothing to do with light or color). Instead hydrogen color is an environmental metaphor for how polluting the production of hydrogen was, primarily ranked by the carbon emissions of the primary power source or source material used to extract the hydrogen. The table to follow describes various means to extract hydrogen and the metaphoric term used to describe the process.

As a metaphor, however, the hydrogen spectrum is neither scientific nor arranged monotonically by color (wavelength) of light. Instead it represents a metaphor for natural purity like green plants, blue water and yellow sun in contrast to ‘dirty’ black coal. As such, green and yellow hydrogen refer to H₂ production from clean energy of renewable sources while brown and black hydrogen refer to processes involving the burning fossil fuels. Every other color is in between.

| Primary power | H₂ Spectrum | Hydrogen Generation |
|---|---|---|
| Wind power | Green: 100% | Large scale wind farm T2G2G |
| | renewable | (turbine-to-gen-to-grid) |
| | | Grid powers electrolysis |
| | | Wind farm T2G2G without power |
| | | transmission |
| | | Local grid powers electrolysis |
| | | in real time |
| | | Off-grid wind fan turbine-to- |
| | | generator |
| | | Gen powers electrolysis off- |
| | | grid in real time |
| | | Optional local storage for |
| | | delayed electrolysis |
| Solar-thermal | Green: 100% | Large scale solar farm and |
| | renewable | boiler for T2G2G |
| | | Grid powers electrolysis |
| Hydroelectric | Green: 100% | Hydroelectric T2G2G |
| | renewable | Grid powers electrolysis |
| Solar-PV | Green or | Photovoltaic arrays directly |
| | yellow: 100% | power electrolysis |
| | renewable | Requires DC/DC conversion & |
| | | batteries to regulate rate |
| | | Optional local high cap storage |
| | | for delayed electrolysis |
| | | Photovoltaic arrays with MPPT |
| | | (max power tracking) |
| | | DC/DC converter powers and |
| | | controls electrolysis rate |
| | | Optional local storage for |
| | | delayed electrolysis |
| Chlor-alkali | Yellow | Electrolysis of saturated sodium |
| | or white | chloride solution (brine) |
| | | Grid power for sodium hydroxide |
| | | & chlorine from salt |
| | | Capture free waste hydrogen |
| | | (unless it is reburned) |
| Natural | White | Naturally occurring, geological |
| hydrogen | | hydrogen found in underground |
| | | deposits, may occur in fracking |
| | | projects |
| Nuclear-electric | Pink | Nuclear heat exchanger for T2G2G |
| | | Grid powers electrolysis |
| Thermo-nuclear | Purple (violet) | Nuclear heat exchanger for T2G2G |
| Nuclear-electric | | powers electrolysis |
| | | Nuclear heat exchanger for chemo- |
| | | thermal electrolysis |
| Thermo-nuclear | Red | Nuclear heat exchanger for chemo- |
| | | thermal electrolysis |
| Natural gas | Blue | Steam methane reforming (SMR): |
| | | steam + NG + catalyst |
| | | Produces H₂ with CO and CO₂ |
| | | byproducts |
| | | Uses carbon capture, storage, |
| | | utilization (CCSU) |
| | | Combines SMR with integrated fuel |
| | | oxidation system |
| | | Improved carbon recapture |
| | Gray | Steam methane reforming (SMR): |
| | | steam + NG + catalyst |
| | | Produces H₂ with CO and CO₂ |
| | | byproducts |
| Methane | Turquoise | Methane pyrolysis with solid |
| | | carbon byproduct |
| | | Thermal, plasma (Kvaerner), or |
| | | catalytic decomposition |
| Igneous coal | Brown | Coal gasification for H₂ with |
| | | CO and CO₂ byproducts |
| | | Benefits from carbon capture, |
| | | storage, utilization (CCSU) |
| Bituminous coal | Black | Coal gasification for H₂ with |
| | | CO and CO₂ byproducts |
| | | Benefits from carbon capture, |
| | | storage, utilization (CCSU) |

Note in the table, the term T2G2G is an acronym for turbine-to-generator-to-grid where a turning turbine powers a generator delivering electricity into the power grid. The force used to drive the turbine may be derived from renewable energy or by consuming a fuel. Renewable sources for T2G2G electric power may include wind power, hydroelectric or geothermal sources, and solar power (aka yellow hydrogen). T2G2G assumes the power grid is capable of absorbing generated energy. Aside from supplying electric into the grid via T2G2G, other turbine-to-generator electric power methods may be employed to directly power electrolysis either contemporaneously or stored locally as electric charge in batteries for later hydrogen conversion, i.e. delayed electrolysis.

In photovoltaic (PV) direct conversion of sunlight, generated electricity may power electrolysis in real time or be temporarily stored in batteries and regulated by a DC/DC converter to maintain a more steady hydrogen generation rate. More elaborate PV systems may include MPPT, an acronym for maximum power point tracking where the solar panel track the suns movement to maximize power generation. Some papers refer to solar PV hydrogen as yellow hydrogen.

Nuclear power also provides numerous means to produce hydrogen. Although nuclear reactors produce radioactive nuclear isotopes as dangerous waste pollutants, nuclear fission does not produce carbon dioxide. So considering atmospheric pollution nuclear power is clean despite representing a radiative contamination risk to soil and groundwater. Moreover nuclear power is not truly renewable as it consumes nuclear fuel and produces waste. As such, nuclear generated electric power for water electrolysis is referred to as pink hydrogen. Purple or violet hydrogen combines pink hydrogen from nuclear-electric powered electrolysis with additional hydrogen generated thermally via a chemo-thermal electrolysis process. Red hydrogen uses high-temperature catalytic splitting of water with nuclear thermal power as its heat source.

Other colors of hydrogen production, such as blue, gray, and turquoise, using processes involving natural gas and methane processing are considered cleaner than coal and oil but are not really considered green-tech. For example, blue and gray hydrogen refer to steam methane reforming (SMR) or auto-thermal reforming (ATR) of gasses combined with or without carbon recapture. Turquoise hydrogen involves thermal splitting of methane via methane pyrolysis producing waste carbon in solid form, producing carbon products but not air pollution.

Black and brown hydrogen involves coal gasification. The environmental cleanliness of coal gasification varies dramatically based on the type of coal used, how its is chemically pretreated, the temperature of the chemical processing, pollutant gas reclaim methods, carbon sequestering, and more. As no single standard coal gasification process exists or is even possible, the carbon footprint of coal gas varies widely. Indiscriminate suppliers and countries often misrepresent how polluting their coal power production is.

An even more complex question involves producing hydrogen as a secondary byproduct of regular chemical production, manufacturing performed whether the hydrogen is captured or just wasted. In this sense, even though the process may produce CO₂, the act of capturing waste hydrogen doesn't produce any additional carbon dioxide because the hydrogen would be made irrespective of whether it is harvested or dissipated. An example of this type involves the conversion of salts into important inorganic chemicals sodium hydroxide & chlorine. As part of chlor-alkali industry, chemical refining comprises electrolysis of saturated sodium chloride solution (brine) where hydrogen is a byproduct. The hydrogen can be captured and burned to generate heat needed in the process improving the overall energy efficiency of the manufacturing process. Otherwise the hydrogen can either be captured or released into the atmosphere. Since the hydrogen capture did not result in any additional CO₂ generation, the hydrogen is referred to as white hydrogen. Some papers more broadly refer to free hydrogen as yellow hydrogen as they don't increase CO₂.

Other hydrogen generation methods involve waste recycling, converting biomass into methane and then into hydrogen. When mixed with gasifying coal, this process is called co-gasification. These processes capture hydrogen from waste gasses generated from methane naturally occurring in the decay of organic compounds and biomass. Efficiency and energy yield is enhanced by mixing, i.e. integrating, fuel sources. Such integrated technologies may combine coal-sawdust, coal-sewage sludge, coal-meat, and coal-bone meal into a source of hydrogen. The coal-meat and coal-bone meal mixtures reported exhibit the best results for hydrogen production. The carbon footprint varies widely depending on the mix of hydrogen sources and the reactions used.

In summary, innumerable means exist to convert primary energy into hydrogen fuel. The forgoing example include green renewable resources such solar and wind; polluting energy sources such as coal and biomass; and intermediate sources such as nuclear and natural gas.

### Transporting Hydrogen.

A separate matter is the challenge of transporting hydrogen. This topic depends on the relative locations of the hydrogen production and where it is converted into electricity. For example, hydrogen-to-electric-power conversion can occur close by the end user or nearby the hydrogen production source. If the conversion occurs near the electricity client, then the hydrogen fuel must be transported from its source to its targeted user community. Alternatively, if the H₂ to electric power conversion occurs near the hydrogen production facility, then the electric power must be transmitted over a grid or transmission line system to the user. Both distribution methods, hydrogen transportation and electric power transmission, face both efficiency and safety challenges.

Hydrogen distribution requires infrastructure to transport pure hydrogen as compressed gas or hydrogen compounds. Hydrogen can be transported by truck in high pressure gaseous form, e.g. 700 bar (H70), or by semitrucks as liquid hydrogen, or by low pressure pipelines, i.e. where P<30 bar. Hydrogen distribution in vehicle transportation market is even more complex as gas stations must be retrofitted to manage hydrogen fuel sales. The details of hydrogen transport are beyond the scope of this invention disclosure.

Conversely electric power transmission means the hydrogen is converted locally but the resulting electrical power must be transmitted over great distances. Although DC transmission offers such capability, most power transmission occurs over AC power grids unaccustomed to non-sinusoidal variable power sources. Transmitting AC power or long distances can lead to instabilities in the power grid destroying transformers, causing fires, and even damaging client devices connected to the grid.

Regardless of the myriad of challenges of hydrogen production and distribution, the opportunity of hydrogen powered homes, factories, and vehicles is compelling. The key component in any of these implementation is the means to convert hydrogen into electric power—a device called a fuel cell.

### Hydrogen Fuel Cell Operation.

Unlike a battery which delivers energy stored previously during electrical charging, a fuel cell converts hydrogen fuel into electrical energy in real time creating electrical energy and simultaneously delivering it to an electrical load. As such, a fuel cell does not require charging, but instead needs processed fuel, generally hydrogen, to operate.

An example of a fuel cell 1 is shown in FIG. 1, where fuel in the form of hydrogen 2 is separated by a chemical catalyst 3 such as platinum or palladium into positive ions and negatively charged electrons, i.e. hydrogen ions 4a (aka protons) and electrons 5a. The anode redox reaction is given by the expression

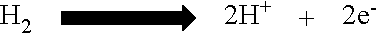

During fuel cell operation, hydrogen ions 4a in the anode travel across an electrolytic membrane 6 to become hydrogen ions 4c in the cathode. There they combine with electron 5c and a reducing agent 7c such as diatomic oxygen 7d to produce water 8. The cathode redox reaction is given by the half reaction

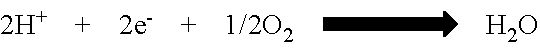

Because anodic generated electrons 5a cannot traverse electrolyte barrier 6, they must take an external path around the cell from anode 10a though load resistance 11 to cathode 10c resulting in usable electric current. In this manner the hydrogen fuel cell converts hydrogen and air (or oxygen) into electricity and water.

This type of fuel cell is referred to as a PEM FC, an acronym for proton exchange membrane or polymer electrolyte membrane. The source of hydrogen, supplied contemporaneously to the cell during operation, depends on the operating temperature range of the fuel cell. Charge transport through the PEM electrolyte occurs via ionized hydrogen cations, i.e. protons. Using a thin film solid electrolyte, PEM FCs do not risk leakage of caustic chemical, acids, or fires of flammable fluids like other older fuel cell technologies used by the space program.

Present-day PEM FCs commonly referred to as low-temperature or LT-PEM FCs employ a solid polymer membrane comprising a sulfonated poly tetrafluoroethylene (TFE) based fluoropolymer-copolymer, chemical formula (C₇HF₁₃)(O₅SC₂F₄) containing an ionomer sidechain of perfluorinated sulfonic acid. First branded Nafion® by Dupont, tradenames of fluoropolymer-copolymer related compounds useful as proton exchange membranes include Aciplex®, Flemion®, Dowew™, and Fumapem F. Morphologically as a fluoropolymer-copolymer, these materials comprise a submicron and nanometer-sized network of hydrophilic domains allowing movement of water and cations across the membrane in one direction while inhibiting the flow of electrons and anions in the opposite direction. As such, the ionomeric membrane favors transport of positively-charged hydrogen ions called cations, over negatively charged electrons, exemplifying a charge exclusion mechanism known as permselectivity or cationic charge selectivity.

FIG. 2 illustrates a structural representation of a fluoropolymer-copolymer film more accurately referred to as ‘perfluorinated sulfonic acid’ or PFSA. As depicted, the polymer contains a long chain or backbone comprising repeated segments of tetrafluoroethylene 21 interrupted after every m repeats of PFE to include an attachment point for a sidechain referred to as a pendant 22 (metaphorically because it dangles from the mainchain) via a CF—CF₂ pair identified by carbon numbers 6 and 9. The length of sidechain pendant 22 varies by the repeated molecules x and y. As depicted x=1 and y=2 but the value of y, i.e. the number of connector (CF₂)_{y} groups may be y=1, y=4, or some other number depending on the manufacturer. Attached to the end of pendant sidechain 22 is the sulfonic acid 23 that functions as the ionomer. Specifically one of the three oxygens temporarily bonds electrostatically onto a hydrogen to form an OH group. In this process the oxygen serves as a negative charge and the hydrogen ion as a positive charge.

### IEM Charge Transport.

Electrical conduction describes the movement of charge particles through a material or medium. Although electrical conduction can occur in a gas, e.g. as current in a vacuum tube; in a liquid during electroplating; or in a plasma such as ionized air carrying a lightening strike, in the vast majority of cases electrical current occurs in solids. In metals like copper and aluminum, electrons are free to move throughout the conductor's atomic matrix without restriction. Because these free electrons occur in great numbers, metals exhibit low electrical resistance whereby even a small applied voltage can produce high current densities.

Semiconductors by contrast are hyperpure crystals comprising elements of Group 14 (classic group IV) such as silicon, germanium, or crystalline carbon (diamond); or manmade compound-semiconductor crystals such as gallium-arsenide, indium-phosphide, gallium-nitride, and silicon carbide which are not conductive on their own. Instead, semiconducting materials lack mobile carriers unless they are doped with impurities. The dopant atoms introduce one charge carrier per impurity atom. By varying the concentration of dopants from 10¹⁴ cm⁻³ to 10¹⁹ cm⁻³, conductance in these engineered materials can be precisely varied over a six orders-of-magnitude despite only representing impurity concentrations of one-part-per-million of the silicon atoms present.

Unlike metals, charge transport in semiconductors can involve two different carriers—electrons and holes, carriers having opposite charge polarities. In N-type semiconductors, silicon is doped with Group 15 (group V) elements such as arsenic (As) or antimony (Sb) called ‘donors. Easily ionized at room temperatures, these donor atoms supply excess electrons unbound from the crystalline structure able to perform charge transport in a manner similar to conduction in a metal. In P-type semiconductors, silicon is doped with group 13 (group III) elements like boron which function as ‘acceptors’. Unlike N-type conduction, these acceptor atoms enable a unique form of charge transport—hole conduction. A hole is a positively-charged virtual particle describing electron vacancies present in a covalently bonded crystal. Rather than comprising a positively-charged particle like a positron, a hole represents the absence of an electron—a missing charge where a covalent bond would otherwise exist in a perfect silicon crystal. Hole conduction occurs indirectly via an electron moving into a vacancy by creating a new vacancy behind it. So as electrons move in one direction, the vacancies they create move in the opposite direction, acting like a positively charged particle.

By contrast, conduction in an ion exchange membrane does not however carry electricity using electrons or holes, but by ionized atoms called ions, cations, or anions. An ion is a atom or molecule after it has gained or lost charge, altering it from its neutral state. The net charge of an ion may constitute either a positive or negative carrier of charge formed either by losing or gaining electrons or by losing or gaining protons. Because they exhibit a net charge, ionized atoms carry the same magnitude of electrical charge as electrons, namely +1 charge for each proton unaccompanied by its electron or −1 charge for each excess electron not counterbalanced by a proton. As an ion may contain one or more ionized atoms and nuclei, the mass of ion is orders of magnitude greater than that of an electron. Whether positively or negatively charged, ions are therefore far less mobile than electrons, exhibiting vastly reduced mobilities and diffusivities compared to electrons. Moreover, unlike semiconductors positively charged cations are real particles (protons), not virtual. like holes

In the presence of an electric field, mobile negative ions called anions conduct electricity in the same polarity as electrons. Anions are so named to identify they are attracted to a positively charged electrode called an anode. Conversely, mobile positive ions called cations conduct electricity in the opposite direction to that of anions. The name cation identifies these positively charged ions are attracted to negatively charged electrodes called cathodes. So while electrons and anions flow in a direction opposite the electric field from negative to positive, oppositely charged protons and cations flow in the direction of an electric field, i.e. from positive to negative. Semantically, current flowing in the same direction as an electric field is referred to as ‘conventional’ current flow, a term-of-art defined by convention, i.e. by general agreement of physicists doing research at the time.

Despite their differences, ionomeric conduction shares more similarities with charge transport in semiconductors than with conduction in metals and semi-metals. Specifically the conductivity of a semiconductor depends on the concentration of immobile impurities called donors and acceptors. These dopants enable the material to predominately transport current either as positive charge or as negative charge. The greater the concentration of immobile dopant atoms in a semiconductor, the lower its resistivity and the greater its conductivity. In an analogous manner, the conductivity of an ionomer is determined by the density of immobile ionomers called ionomers present within its polymeric matrix. Like semiconductors, the ionomers can conduct either positive ions or negative ions but not both. Also similar to semiconductors, the higher the density of immobile ionomers present within the film, the lower its resistivity and the greater its conductivity.

In this sense an ionomer able to accept and release positive charges in a proton exchange membrane functions similar to that of immobile acceptor atoms doping P-type semiconductor material. Conversely ionomers able to conduct negative ions in an anion exchange membrane function analogously to immobile donor impurities doping N-type semiconductors.

Another way ionomers and semiconductors are similar is both conduct current using two different mechanisms—diffusion and drift. Diffusion is charge conduction resulting from a concentration gradient of carriers where randomized movement of ions due to thermal vibration attempts to reduce concentration imbalances. Accordingly, the concentration of newly generated ionized hydrogen at the anode-membrane interface is higher than that at the cathode-membrane interface, producing a gradient dQ/dx and producing the diffusion current I_{diff}/A=−qD(dQ/dx). By contrast, electrical drift is conduction resulting from electrostatic force exerted by an electric field.

The drift current is I_{drift}=p(qQ)(dV/dx). The drift current in the ionomer is limited by its low electric field. Supporting at most only 0.9V across a 20 μm film has an equivalent electric field of dV/dx=0.9V/20 μm)=450 V/cm. Because of the low electric field along a tortuous path, the diffusion current represents 90% of current conduction in a 20-μm thick Nafion® PEM membrane. This means the proton concentration gradient determines the transport rate of charge across the membrane and sets the membrane current, not the miniscule voltage present across the membrane.

### Ionization Processes.

In a fuel cell ions play numerous roles. Firstly, ions form the ionomers attached to the polymeric backbone used to transport charge across the membrane. Secondly, ions created from a fuel source are used to power the electrical power generation. Lastly ions are the basis of ionic liquids able to enhance membrane conduction. In any of these cases a neutral atom or molecule must first be ionized before it contributes to fuel cell manufacture or operation. This process is referred to as ionization.

In physical chemistry, ionization involves an atom or molecule gaining or losing electrons or protons. Ionization commonly occurs with ionic salts in order to empty or fill the atomic shell of the host atom. For example, the six alkali metals of Group 1 in the periodic table of the elements such as sodium (Na) and lithium (Li) each have one electron in their outermost shell. As such, they readily relinquish the electron to create a more stable electronic state. Likewise, any of the seven elements in group 17 (group VIIA) such as fluorine, chlorine, bromine, iodine, and astatine, referred to as halogens represent highly reactive non-metal elements lacking a single electron in their outer shell. These elements willingly attract an extra electron in order to fill the outer shell to create a more stable electronic state.

The process where a reactant surrenders an electron to another atom or molecule is referred to as oxidation, even when oxygen is not involved in the reaction. As such, the process of oxidation occurs when a reactant loses electrons during the reaction. Conversely, reduction occurs when a reactant gains electrons during a chemical process with another atom or molecule. Since every atom or molecule being oxidized must interact with another being reduced, the coupled reaction is referred to as a redox reaction, a portmanteau concatenating reduction and oxidation. Once reacted, the chemical species having lost electrons is described as oxidized while the reactant that gained electrons is described as ‘reduced’.

The electrical effect of a redox reaction on material properties, however, is not solely decided by the charge transfer process, but by mobility of its reaction products. Specifically, if the chemical products are immobile, i.e. chemically bonded to a large molecule, crystal or semi-rigid atomic lattice, no change in DC conduction will result from the ionization process. If however, one or both of the ionized molecules are mobile, then electrical current can result from the movement of the ions.

Aside from forming ions through electron transfer, another ionization mechanism involves proton transfer. Although individual atoms cannot change their number of protons without a nuclear reaction, molecules containing atomic compounds can change their net charge state by surrendering or gaining hydrogen ions by bonding to or releasing protons or small molecules.

The process of a molecule changing from a neutral charge state into an ion by gaining a proton and developing a net positive ionic charge is called ‘protonation’. Protonation normally occurs by electrostatically attracting and bonding ionized hydrogen to neutral atoms to form a cation, a positively charged ion attracted to a cathode—the negatively biased electrode forming an electrode field. In some instances a molecule may form chemical bonds with ionized molecules, in which case the new molecule assumes the net charge state of the sum of its predecessor molecule's charge states. So although this process is not as simple as hydrogen ion bonding, it is still often phenomenologically considered as protonation.

Alternatively, bonding a molecule to hydroxide (—OH) gains a net negative charge. This molecular modification can be performed in two sequences. In one case, molecular bound water (H₂O) is stripped of one hydrogen to create the —OH radical in situ, thereby conferring a net negative charge to the molecule—a process referred to as ‘deprotonation.’ In the other case a molecule first becomes negatively charged radical using either redox reactions or deprotonation, and then is bonded to a neutral molecule, crystal, or polymer to form a negatively charged functional group.

In PEM fuel cell fabrication, an ionomer typically comprises an acid such as sulfonic acid (HSO₃) that in aqueous solution surrenders its hydrogen as a proton (H⁺) leaving the immobile anionic ionomer SO₃⁻ bonded to the polymer. Similarly, ionization may be used to create ionic liquid dopants used to modulate the conductivity of the membrane. These IL dopants augment ionomeric hopping conduction by creating alternate conduction paths. In operation, ionization occurs in the anode catalyst layer which strips electrons from hydrogen fuel to produce a conducting proton (H⁺).

The combination of newly ionized hydrogen entering the membrane plus deprotonation of the membrane attached ionomers creates an equilibrium condition that controls overall conduction and energy conversion.

In deprotonation on an ionomer, hydrogen weakly bound to the oxygen is easily released in the presence of any electric field, concentration gradient, or water molecules which act as molecular transport for the hydrogen. In this way depending on the level of hydration in the membrane and catalyst layer the hydrogen ion can float with water or hop from oxygen-to-oxygen atoms as shown in FIG. 3. Since oxygen is negatively charged only a positive ion can charge-hop from one ionomer to another. This mechanism explains why PFSA can only conduct positive charge but not negative ions or electrons. The left side schematic represents a simplified model of an ionomer film comprising an chemically inert electrically inactive backbone 30 with a number of attached “pendants” comprising sidechains 31 attached to an ionomer. In the example shown, the ionomer is sulfonic acid SO₃H of the generic form S(═O)₂(OH) comprising one sulfur atom with double bonds to two oxygens and a single bond to a hydroxyl group OH. In a fuel cell, the hydroxyl molecule is easily ionized removing a positive hydrogen ion, i.e. a proton, thereby conferring a net negative change to the ionomer shown negatively charged groups 32a and 32b.

The hydrogen once stripped from the quasi-immobile pendant typically bonds with interstitial water in the matrix, forming an electrostatic or hydrogen bond and sequestering the resulting negatively charged water molecule 33 to the sulfonic ionomer as part of the PFSA polymer. Once the bond is formed between the sulfonic oxygen and the water's excess hydrogen, the proton can hop from one bond to another and from one water molecule to the next, a process called charge hopping or the Grotthuss mechanism depicted by charge transport arrows 34a and 34b. At excess levels of hydration the hydrogen bond may dissociate creating a positively-charged water molecule H₃O referred to as a hydronium ion. As the hydronium ion contains an excess proton, it is highly reactive and chemically short lived, easily passing charge to surrounding water molecules.

In this way, there is an intimate connection between water transport and charge transport in a proton exchange membrane. The prevailing charge transport mode is therefore a function of membrane hydration. At lower hydration levels, the ionized water remains sequestered whereby hopping conduction from one ionomeric group to the next is dominant. Hopping conduction is depicted in the lower right schematic as a linear row of water molecules 36a, 36b, 36c, and 36d sharing one excess proton 37 which hops 38a from molecule 36a to 36b at time t₁, and subsequently hops 38b from molecule 36b to 36c at time t₂, then hops 38c from molecule 36c to 36d at time t₃, and so on.

At higher levels of hydration, excess ionized water molecules dissociate and move through the matrix as molecular transport also referred to as ‘vehicular transport’, because the ionized water acts a charge carrier. As shown in the upper right schematic, this process occurs by the same ion 35a moving interstitially through the PEM matrix and its pores, drifting or diffusing from position (x₁, y₁, z₁) at time t₁ to position (x₂, y₂, z₂) at time t₂ to position (x₃, y₃, z₃) at time t₃ without transferring its charge to the surrounding matrix. The driving force for vehicular conduction may be diffusion from a charge concentration differential or from electric drift, an electrostatic force resulting from a local or global electric field propelling the ions. So while vehicular conduction is three-dimensional and benefits from increased porosity in bulk conducting ionomers like pure PFSA, charge hopping occurs from pendant to pendant linearly along the length of the polymeric backbone and only transitions to bulk conduction when interstitial water levels rise too high to still constrain transport to 2D linear conduction. Since at moderate currents PFSA coated polymers like PTFE conduct primarily through two-dimensional charge hopping from pendant to pendant, the conductivity of a CRM reinformed composite membranes is unsurprisingly lower than bulk ionomers like pure PFSA. Offsetting this disadvantage, CRMs exhibit higher mechanical strength and better manage water trapping and membrane swelling. As such, CRMs compromise electrical vs material properties.

In general then, conductivity of PFSA is thereby determined by the molar concentration of ionomers, i.e. how often a pendent occurs every ‘m’ repeats of TFE and the length of the pendant as measured by the equivalent weight ‘EW’ of the polymer. FIG. 4A illustrates several versions of PFSA including Nafion® from Chemours (formerly Dupont) with long sidechain 22a, short sidechain 22b made by 3M, and Aquivion® with short sidechain 22c having y-values 2, 4, and 2 respectively. Note that because all these film contain repeating TFE subgroups 21a, 21b, and 21c, they are often somewhat confusingly referred to as PTFE rather than PFSA. Pure PTFE 21 has no pendant sidechains and is a hydrophobic electrical insulator while PFSA is a hydrophilic cation conductor. Other fluorocarbon mainchain variants also exist. In some sense, pure PFSA membranes may be considered as a special case of a PFSA-PTFE CRM where the PTFE segment is limited to TFE snippets. As shown the various forms of PFSA-PTFE polymers uniquely identified for clarity's sake as segments 21a, 21b, and 21c all contain an identical PTFE backbone segment 21 of (C₂F₄)ₘ interspersed with a common spinal attachment segment 24 comprising (C₂F₃O)ₙ bonded to various sidechains 22a, 22b, or 22c.

A more systematic approach to describe PFSA-PTFE based polymers is illustrated in FIG. 4B defining the polymer in terms of the length of its subunits m, n, x, y and z. Specifically as shown ‘m’ refers to the number of poly TFE repeat units, i.e. the portion 21h that is inert tetrafluoroethylene (TFE) identical the backbone 21 of Teflon®. PFSA segment 24 differs from PTFE in that one of the CF₂ on-chain molecules is swapped by a FCO subunit, i.e. replacing a fluorine atom with oxygen onto which the pendant attaches. The variable ‘n’ defines the portion of the mainchain comprising PFSA 24, while z describes the total length of the chain. The pendant sidechain 22 that connects the mainchain to ionomer 23 comprising a CF₂ molecule bound to the on-chain oxygen and bound to a radical R of varying length x and molecular constitution. The radical R connects to ionomer 23 through a string of one or more CF₂ moieties repeated in y instances, i.e. (CF₂)_{y}.

Commercial variants of pendants range from (x=1, y=2) for Nafion® to (x=0, y=4) for 3M. A slightly shorter pendant from SSC comprises (x=0, y=2). Aquivion® from Sigma-Aldrich is extremely short with (x=0, y=1). Other commercial products offer varying length pendants. Aciplex® from Asahi Kasei corporation for example varies for x=1-3 with y=2-5 while Flemion® pendants from AGC chemicals company vary with x=0-1 and y=1-5. GoreSelect® from WL Gore & Associates, while constructed using a proprietary formulation, comprises a reinforced PFSA sacrificing conductivity for the ability to produce stable films 20-um or less in thickness.

Since the pendant is a varying composition, a simplified model eliminates its details as depicted schematically by dashed line 22z or on even more simplified form where the mainchain is simply replaced by a line. Note that the substation of fluorine by oxygen on the polymeric mainchain represents the consequence of fabrication of PFSA-PTFE in a bulk chemical reaction. In the bulk form, a dispersion of PFSA can be casted (cast molded) or extruded at temperature to produce the film.

It should be noted that whether TFE segment 21h is referred to as TFE or PTFE is a matter of semantics—the composition of the segments are identically tetrafluoroethylene and they are both linked with PFSA backbone 24 to form a polymer. The only distinction in naming is the length ‘m’ of the TFE segment on the mainchain. Imprecisely if the length ‘m’ is small, the segment may be referred to as TFE and the chain as the bulk homopolymer PFSA, i.e. with no recognition of the hydrophobic PTFE segment in its name. Conversely, if ‘m’ is large, the hydrophobic poly TFE backbone segment 21h dominates the structural, physical, crystalline, and electrical properties of the film whereby the IEM is referred to as a PFSA-PTFE heteropolymer composite reinforced membrane (CRM). While the distinction appears arbitrary, there are fundamental differences between the two membranes. Although nascent PFSA, i.e. where ‘m’ is small, is semi-amorphous and behaves as a bulk conductor, in PFSA-PTFE CRMs the large values of ‘m’ means the PTFE fraction is a higher percentage of the film's molecular weight. Since pure PTFE, aka Teflon® is quasi-crystalline with a high atomic density, minimal porosity, and high hydrophobicity, increasing the length ‘m’ and PTFE fractional content in the CRM makes the PFSA-PTFE heteropolymer structurally stronger and less conductive than its PFSA homopolymer counterpart. The tighter crystalline-like matrix also suppresses oxygen back-streaming and fuel crossover, improving the use life of the membrane especially in direct methanol fuel cells (DMFCs). Throughout the remainder of this application, the terms PFSA homopolymer and PFSA-PTFE heteropolymer will be considered as a continuous spectrum of the same material rather than distinct chemical compounds or IEMs.

As an alternative to its bulk form PFSA can also be synthesized as a coating. In the coating process a polymer such as PTFE or PFSA-PTFE is first molded or extruded then subsequently treated with PFSA to coat the film. As shown in FIG. 5 this process involves disrupting the PTFE chemically using solvents to form graft points 29 to which the pendant attaches. As shown, the oxygen substitution of fluorine on the mainchain, depicted as X representing the pendant attach point, is not limited to oxygen atoms especially when graft point 29 is induced by radiation damage. Because the thin PFSA coating adheres to the PTFE skeleton, the conduction in this kind of film may also be considered surface rather than bulk conduction. Moreover the process by which PFSA is coated onto PTFE is often times regarded as a trade secret because the synthesized compound must overcome an intrinsic incompatibility between hydrophilic PFSA material and the hydrophobic PTFE.

Regardless of whether bulk or surface conductive films are used, fuel cell operation involves separating positive and negative charges on two sides of a semipermeable membrane. The ion exchange membrane can therefore be considered as a solid electrolyte. According to Wikipedia, “an electrolyte is a medium containing ions that are electrically conductive through the movement of those ions, but not conducting electrons.” The most mobile charge in an electrolyte is ionized hydrogen (H⁺) commonly present in chemical, biochemical, and biological processes. In this sense, phenomenologically, ionomers mimic subunit-V of cytochrome-c oxidase (CCO-V), a mitochondrial transmembrane protein commonly known as ‘ATP synthase’ responsible for creating and storing biochemical energy as adenosine triphosphate (ATP).

Emulating the regulatory function of the electron transport chain in cell biology, synthetic ionomers comprise a blend of both electrically neutral repeating units and ionized units (typically carboxylic acids) covalently bonded to a polymer backbone. In essence, the lipid bilayer in mitochondria forms a charge barrier much the same as the PEM membrane bifurcates the anode and cathode regions within a fuel cell. In mitochondrial respiration, cytochrome-c and group V cytochrome-c oxidase (CCO) separates electrons from protons much like the anode catalyst layer splits the two in a fuel cell. Likewise CCO continues to pump protons across the lipid bilayer to establish a mitochondrial membrane potential (MMP) which ultimately powers ATP synthesis. In a fuel cell, a slight difference in pressure across the ionomer maintains a higher proton concentration in the anode which necessarily traverse the PEM membrane to the cathode where hydrogen is not present. In both cases, a difference in ionized hydrogen concentrations sustained across a semipermeable membrane drives the production of usable energy either in the form of the bioenergetic molecule adenosine triphosphate (ATP) in mitochondria, or electricity in the case of a hydrogen fuel cell. The final step in both processes is an oxygen reduction reaction resulting in water as a byproduct.

By limiting ionized subgroups in a fuel cell to 15 or 20 mole percent, the membrane splits positive and negative charges while managing current flow, in essence performing the same function as a semiconductor diode. Variations of the membrane are use in the separator of lithium ion batteries and in kidney electrodialysis. That said, numerous deficiencies exist in present day proton exchange membranes, especially involving a strong temperature and humidity dependence, swelling and deformation with hydration, and an inability to function at freezing temperatures.

The term “low temperature” in the acronym LT PEM FCs is a misnomer as it refers to operating temperatures lower than most other fuel cell varieties. Specifically Nafion® based PEM FCs typically operate in the 60° C.-to-80° C. range, significantly above normal ambient temperatures on earth. A variant of PEM fuel cells called a high temperature of HT PEM FC employs lead-doped Nafion® and a modification of the platinum catalyst to platinum-ruthenium. With this modification, the operating temperature range increases to the range of 110° C.-to-180° C. Both LT and HT variants of Nafion® PEM FCs are not particularly useful at room temperatures of 25° C.-to-50° C. and are completely non-functional in freezing conditions at T 0° C. As such, Nafion® based PEM FCs are often considered as unsuitable for consumer use and problematic for transportation applications subject to operation over wide temperature ranges.

Another variation of the PEM FC, the direct methanol fuel cell replaces gaseous hydrogen with methane as fuel. This method beneficially reduces the operating temperature of a fuel cell to the 30° C.-to-60° C. range. The anodic reaction changes to CH₃OH+H₂O→CO₂+6H⁺+6e⁻ and the cathode reaction is modified to 1.5O₂+6H⁺+6e⁻→3H₂O. Unfortunately the direct methanol fuel cells emits carbon dioxide. In automotive applications this means that cars remain CO₂ polluters where carbon sequester methods are not applicable. As such, direct methane PEM FCs are unsuitable for consumer use or in transportation applications and are not considered green energy sources. That said, methanol is an abundant source of bioenergy in earth's ecosphere and less polluting than fossil fuels involving coal or refined crude oil. No solution is perfect.

### Other Fuel Cells.

Although hydrogen PEM FC represents the most promising type of fuel cell, other fuel cells with different chemistries exist. FIG. 6 illustrates four exemplary non-PEM fuel cell types—the alkali fuel cell aka AFC, MCFC, PAFC, and SOFC.

Alkali fuel (AFC) cells operate on compressed hydrogen and oxygen with potassium hydroxide (KOH) as an electrolyte with H₂O as a byproduct. Ionic transport within the electrolyte involves negatively-charged hydroxyl (—OH) anions 42a. Oxygen enters cathode 41a while hydrogen enters anode 40a. Negatively-charged hydroxyl (—OH) anions 42a flow from cathode to the anode, combine with the hydrogen and release water on the anode side of the cell. Using a fluidic electrolyte means AFCs risk leakage. Moreover the cells require high temperature operation, between 150° C.-to-200° C. Therefore AFCs are not considered suitable or safe for consumer use or in most transportation applications.

Molten carbonate fuel cells or MCFC comprise high-temperature compounds of sodium or magnesium carbonate salts such as Na₂CO₃ as their electrolyte. Charge transport comprises carbon trioxide (CO₃²⁻) anions 42b. The fuel cell consumes H₂, O₂ and beneficially CO₂ and releases water but is sensitive to carbon monoxide (CO) poisoning. Specifically oxygen O₂ and carbon dioxide CO₂ enters cathode 41b while hydrogen enters anode 40b. Negatively-charged divalent carbon trioxide (CO₃²⁻) anions 42b flow from cathode to the anode, combine with the hydrogen and release water on the anode side of the cell. Aside from consuming CO₂, another benefit in MCFC use inexpensive nickel rather than platinum as a catalyst. Its high operating temperature, roughly 650° C., renders MCFC unsuitable for consumer use or in transportation applications.

True to their namesake, phosphoric acid fuel cells or PAFCs use phosphoric acid, chemical notation H₃PO₄, as their electrolyte. Like PEM fuel cells, charge transport in a PAFC involves H⁺ cations. In operation the cell consumes hydrogen and oxygen and produces water. Specifically hydrogen enters anode 40c where it is ionized into protons and flow to cathode 41c where it recombines with oxygen O₂ to form water. Unfortunately the presence of liquid phosphoric acid heated to 200° C. makes PAFC extremely dangerous for use except for industrial applications. As such, PAFCs are not considered safe for consumer use or in transportation applications.

Solid oxide fuel cells or SOFCs utilize a metal infused ceramic compound such as oxides of zirconium or calcium (yes, calcium can behave as a metal) as an electrolyte including YSZ, ScSZ, and GDC. Fed by oxygen entering cathode 41d, charge transport involves divalent oxygen O²⁻ anions 42d flowing from the cathode to anode 40d where it recombines with hydrogen to form water. Although the solid electrolyte cannot leak, the ceramic can crack from impact or repeated temperature cycling to its nominal operating condition of 1,000° C. These excessive operating temps limit high temperature limits applications of SOFC units to large scale industrial applications, and are unsuitable for small consumer use or transportation applications.

The largest purveyor of SOFCs, Bloom Energy, employs a fuel cell which according to their public shareholder representations is able to convert a variety of fuel types, namely natural gas (NG); biogas (biogas); and blended hydrogen (bH₂) a mix of natural gas, low carbon H₂, and biomethane into electricity. Despite its purported versatility, reported disadvantages of the Bloom SOSC fuel cell system include high temperature operation at 800° C., polluting byproducts, high capital costs, and a correspondingly low return on investment (ROI), reportedly with a investment TTR of up to 8 years.

In conclusion, as summarized in the table below, a variety of fuel cells exist, none of which are suitable to meet the consumer and transportation market requirements. Aside from emerging PEM membranes, the only low temperature fuel cell technology today produces CO₂ as a waste gas. Of these technologies, the proton exchange membrane, aka PEM fuel cells, have the best chance to being readapted for lower temperature operation especially for room and at freezing temperatures commonly encountered at high altitudes and in polar regions.

Among the listed options, PEM fuel cells continue to present the best opportunity for improvement and commercial adoption. Advantages of the PEM FC include its us of a thin solid electrolyte, ease of assembly, and no concern for leaking caustic chemicals or acid. Note than in membrane based fuel cells, the membrane is considered an ‘electrolyte’ which can be defined as type of semipermeable polymeric material that exhibits the property of conducting ions while impeding the mixing of reactant materials across the membrane.

| | Electro- | Ion | | | |
|---|---|---|---|---|---|
| FC Name | lyte | Transport | Fuel | Effluent | Temp ° C. |
| Methane | PEM | H⁺ | CH₃OH, | CO₂, | 30-60 |
| PEM | | | H₂O | H₂O | |
| LT PEM | PEM | H⁺ | H₂, O₂ | H₂O | 60-80 |
| HT PEM | PEM | H⁺ | H₂, O₂ | H₂O | 110-180 |
| Alkali | KOH | —OH | H₂, O₂ | H₂O | 150-200 |
| AFC | | | | | |
| PAFC | H₃PO₄ | H⁺ | H₂, O₂ | H₂O | 180-200 |
| MCFC | Na₂CO₃ | CO₃²⁻ | H₂, O₂, CO₂ | H₂O | 650 |
| SOFC | YSZ, | O²⁻ | H₂, O₂ | H₂O | 1000 |
| | ScSZ, | | | | |
| | GDC | | | | |

### PEM Fuel Cell Construction.

As shown in FIG. 7 a schematic of a single membrane PEM fuel cell absent the cell housing is depicted revealing its layer-by-layer structure. An expanded view of cell construction illustrates two gas diffusion layers 90 and 94 where anode diffusion layer 90 includes a hydrogen fuel inlet and a second port, an outlet for recycling unused hydrogen.

Conversely, the cathode gas diffusion layer 94 has an oxygen inlet and a water outlet. Since fuel cell operation produces water, water removal is critical to maintain operation without flooding the cell electrolyte. Sandwiched between the gas diffuser layers are the anode catalyst 91, cathode catalyst 93, and the intervening proton exchange membrane (PEM) layer 92. PEM layer 92 comprises the permselective polymer of ionomer-impregnated PTFE film such as PFSA-PTFE having a thickness typically 100 microns thick.

Anode catalyst layer (ACL) 91 includes platinum or palladium typically bound within a carbon matrix, whose purpose is to dissociate hydrogen into protons (cations) and electrons. Because the oxygen reduction reaction (ORR) on the cathode side of the PEM more significantly affect the reaction rate and impedance of the fuel cell, Pt loading in the anode catalyst can be reduced without affecting electrical performance. While this strategy may appear to represent an opportunity for cost savings, low Pt anodes are at substantially greater risk for severe contamination from the chemical impurities present in the fuel.

Contaminants such as carbon oxide, hydrogen sulfide or ammonia can react with platinum particles creating strong, nearly irreversible chemical bonds, consequently decreasing the electrochemical surface area and irrevocably damaging the cell. As such, very low anode catalyst loading is ill advised. New developments include tantalum-doped titanium dioxide (TiO₂) or alternatively combining TiO₂ with SiO₂ using vinyltrimethoxysilane (VTMS) as a binder.

On the cathode side, catalyst layer 93 accelerates the oxygen reduction reaction (ORR) combining electrons, protons, and oxygen to produce water. The stoichiometry and structure of the cathode catalyst layer continues to evolve. Present day designs comprise carbon infused with platinum. To reduce costs, new efforts attempt to develop alloys of Pt—Ni, Pt—Co, Pt—Gd, Pt—Y, Pd, and Pd-Au. Other approaches include nanoparticles, nanostructures, nanosheets, and carbide cores.

Another important element in a PEM FC is the bipolar plates used to conduct current out of the fuel cell assembly and to form channels to carry coolants if needed. The properties of these metallic bipolar plates include
Low resistivity, good electrical conductivity (ρ<10 Ω-cm, σ>0.1 S/cm)
Affordable cost (no rare materials, high volume capable)
RoHS compliant, Pb free
Superior thermal conductivity (θₜₕ>20 W/cm²)
High chemical and corrosion resistance
Mechanical stability against compression
Chemically stable over operating temperature range
Resilient to oxidation in high humidity
Reliable during temperature cycling
Low weight per volume
Recyclable, inexpensive metal reclaim

The primary design criteria of a bipolar plate is its shape and its gas channels. Made in accordance with this invention, the gas channels also include a small reservoir called a manifold to ensure uniform gas distribution throughout the channels and across the MEA5.

### PEM FC Electrical Characteristics.

The electrical properties of a proton exchange membrane fuel cell depend on its design, materials, manufacturing, and fuel. Assessing the utility of various constructions of PEM fuel cells, however requires a common basis of comparison. Like the previous discussion regarding lithium ion batteries, a relevant comparison of electrical performance can be made using a lumped-element equivalent circuit model.

FIG. 8A illustrates one basic model for a fuel cell comprising an open circuit voltage 100 of magnitude V_{chem}, a DC resistance 104 of magnitude R_{ohmic}, and dynamic elements 103 comprising FC polarization voltage 101 of variable magnitude Vₚₒₗ and membrane resistance 102 of variable magnitude R_{memb}. The fuel cell terminal voltage V_{FC} is then given by the equation

$${V}_{FC} = {V}_{chem} - {V}_{pol} - \vert \cdot ( {Z}_{memb} + {R}_{ohmic} ) \approx {V}_{eff} - \vert \cdot ( {R}_{memb} )$$

where the dynamic impedance Z(t) is given by

$$Z ( t ) = \frac{{V}_{pol}}{I} + {Z}_{memb}$$

and where real components V_{eff}≈V_{chem}−Vₚₒₗ and R_{memb}≈Re {Z_{memb}}>>R_{ohmic}. This equivalent simplified model is depicted in FIG. 8B where the effective FC voltage 100 and DC membrane resistance 102 are both a function of temperature T, relative humidity of the anode RHA, relative humidity of the cathode RHC, and current density I/A.

To accommodate these interdependences a modified phenomenological model of a PEM fuel cell is depicted in FIG. 9A highlighting the role of humidity (water vapor) and water transport in the cell. Adapted from FIG. 1, the diagram includes the various roles of water in fuel cell operation. Identified elements include enclosure or encasement 120, PEM membrane 122 with anode catalyst layer 124a and cathode catalyst layer 124c. The catalyst layers are bounded by electrically conductive gas diffusion layers 123a and 123c on the anode and cathode side of the PEM membrane respectively.

The core of the fuel cell is the energy conversion element assembly commonly referred to as the ‘membrane electrode assembly’ or MEA. The precise definition of the fuel cell core depends on how many layers are included. When referring to the PEM layer and its two catalyst layers, the sandwich may be referred to as a MEA3 in reference to its three constituent layers. The most common definition of a membrane electrode assembly is MEA5, meaning the MEA3 core plus its two enclosing gas diffusion layers. The term MEA7 refers to the structure comprising MEA5 plus two sealant rings inserted to prevent gaseous leaks between the gas diffusion layers and the conductive bipolar plates carrying gasses. MEA7 is considered a term-of-art, but not commonly referred to in publications outside of the field of fuel cells.

The role of water in PEM FC operation is critical. If the water content in the fuel cell is too low, reactivity drops, electrical impedance is increased, and delivered power is significantly reduced. To prevent the fuel cell from “drying out” water vapor must be mixed into hydrogen fed to the fuel cells. Specifically gasses supplied to anode chamber 121a comprising incoming hydrogen 75 must be humidified by water vapor 81a. The humified hydrogen 128a is then split in anode catalyst layer producing electrons and protons intermixed with H₂O molecules. Unused gasses 129a effused from anode gas channel 121a include both hydrogen and water vapor.

This mix can be resupplied, i.e. recirculated, to supply the inlet gasses 128a to the anode with no additional consumption of energy. Concurrently water vapor transported 127a through the anodic gas diffusion layer 129a reaching the anode catalyst layer 124a supports ion transport and fuel cell energy production, especially during fuel cell startup when the membrane is dry. Unused excess water diffuses in the reverse direction 127a back across the diffuser layer returning to anode gas chamber 121a in an unused state.

The role of water in cathodic reactions is equally critical. In this example, humified air 128c is supplied to the fuel cell cathode gas channel 121c as a blend of air and/or oxygen 80 mixed with water vapor 81c, i.e. gaseous H₂O. Combining O₂ 60 with gaseous water 81c in the cathode gas channel 121c, the cathode mixture regulates the oxygen reduction reaction (ORR) in the cathode by traversing 127c the cathode diffusion layer 123 to the catalyst layer 124c thereby regulating proton cation reduction into water. In equilibrium, since the process generates additional water in the catalyst layer the excess water flows 127c across the diffusion layer in the reverse direction, increasing the humidity in cathode gas channel 121c which is regulated to the proper level by effluent removal 129c.

Since both water transport 127a in the anode and 127c in the cathode maintain equilibrium, the role of water is crucial in determining the fuel cell current and impedance. Too little water will dry out the cell, making start up difficult. Too much water can adversely affect PEM FC performance. For example, excess humidity in the anode can reduce proton transport across the membrane, a phenomena referred to as electroosmotic drag shown by arrow 125. Excess humidity in the cathode can cause back diffusion of water 126 lowering cell efficiency and comingling anodic and cathodic water. In normal operation, water in the cathode should remain separate and distinct from water vapor in the anode.

As such, even though the efficiency of a PEM FC is often described in reference to the relative humidity of the ambient, in more details the anode and cathode relative humidity are not the same and should be specified separately. For technical clarification, the term relative humidity or RH describes the percentage water vapor, i.e. the water vapor partial pressure, in a gas is defined by the ratio of the ambient gas temperature divided by the gas dew point temperature—the temperature where water comes out of solution changing from its gas phase into liquid.

For convenience sake, it is common practice to specify the RH for a fuel cell as a single value for both anode and cathode with the understanding that better results may be obtained by optimizing the two RH values separately. Note also that the schematic shown in FIG. 9A represents the cross section where gas channels are present on both the anode and cathode side of the cell and where the bipolar plate electrodes are not visible. For further clarity FIG. 9B illustrates the addition of bipolar conductive plates to the cell carrying both electricity and gasses.

As depicted, anode gas channel 121a carrying humidified hydrogen 75 is formed within anode bipolar plate 119a. Some cross sections where anode bipolar plate 119a directly contacts the anode gas diffusion layer 123a do not include the gas channel. Instead gas carried by gas channel 121a spreads in all directions 117a throughout anode gas diffusion layer 123a to uniformly reach the anode catalyst layer 124a. Various anode gas channel geometries not shown including grids and spirals have been investigated to provide maximum uniformity to the MEA3. In addition to housing the gas channel, anode bipolar plate 119a conducts electric current from the MEA5 via anode gas diffusion layer 123a. As such, both anode gas diffusion layer 123a and anode bipolar plate 119a must feature lower electrical resistance.

Similarly, cathode gas channel 121c carrying humidified oxygen 80 is formed within cathode bipolar plate 119c. Some cross sections where cathode bipolar plate 119c directly contacts the cathode gas diffusion layer 123c do not include the gas channel. Instead gas carried by gas channel 121c spreads in all directions 117c throughout cathode gas diffusion layer 123c to uniformly reach the cathode catalyst layer 124c. Various cathode gas channel geometries not shown including grids and spirals have been investigated to provide maximum uniformity to the MEA3. In addition to housing the gas channel, cathode bipolar plate 119c conducts electric current from the MEA5 via cathode gas diffusion layer 123c.

As such, both cathode gas diffusion layer 123c and cathode bipolar plate 119c must feature lower electrical resistance. Note also that depending in the location of the cross section, various combinations of bipolar plates and gas channels may or may not be present in an illustration. For example, the cross section shown in forementioned FIG. 9A depicts the cut line 118 of FIG. 9B.

As described, the electrical characteristics of a PEM fuel cell primarily depend on the relative humidity RH of the anode and cathode, the cell temperature, and on current density. Low gas flow from inadequate supply pressure, localized heating (hot spots), and carbon monoxide (CO) poisoning of the catalyst may also impact operation.

The following sets of curves exemplify the electrical properties of prototype PEM fuel cells published in the literature, all of which suffer from serious performance and reliability challenges. They are included herein to provide mechanistic insight into FC operation. FIG. 10 illustrates the effective terminal voltage V_{FC} of a PTFC based fuel cell at 70° C. as a function of current density I/A for relative humidity ranging from 100% to 0%. Each curve exhibits a characteristic response comprising an electrochemical potential voltage 149 at near zero current of value V_{chem} which drops to a lower effective voltage 147 of magnitude V_{eff} with only a slight electrical current load. The voltage difference is the no-load polarization voltage 148 given by the relation Vₚₒₗ=V_{chem}−V_{eff}.

Aside from the initial voltage drop Vₚₒₗ at low current, each response curve above 27% relative humidity has a characteristic shape with increasing current comprising a quasi-constant voltage plateau followed higher current knee, beyond which a precipitous cell voltage drop-off occurs. The values of V_{chem}, Vₚₒₗ, V_{eff}, and V_{FC} (I/A) vary by fuel cell design and chemistry. For the illustrated example using a PTFC membrane, V_{chem}=1V and V_{eff}=0.83. At a current density of 400 mA/cm², the effective terminal voltage V_{FC} monotonically decreases with humidity, specifically 0.65V, 0.58V, 0.40V, and 0.35V respectively for different values of relative humidity, namely RH=100% for curve 140, 60% for curve 141, 35% for curve 142, and 27% for curve 143. Although higher values of relative humidity are able to maintain greater cell voltages at low current densities, the corresponding knee current at V_{FC}=0.2V occurs at monotonically lower current densities, e.g. at densities of 1.3, 1.25, 1.0, and 0.75 A/cm² for RH values of 27%, 35%, 60% and 100% respectively.

Below 20% humidity, the behavior of the fuel cell differs considerably from higher humidity operation. For example, at RH=20% curve 144 exhibits voltage collapse at any current over 0.1 A/cm² with no voltage plateau present. As indicated by curve 145, at 0% relative humidity the fuel cell is incapable of delivering any current whatsoever. Both of the curves represent a condition when inadequate water is present to support the fuel cell's minimum sustainable chemical reaction.

An important observation is that although the effective voltage V_{eff} 147 does not vary significantly with temperature and humidity, the fuel cell is incapable of generating and sourcing significant current at that voltage. For voltages below V_{eff}, the voltage-current characteristic spreads into a family of diverging curves each representing different relative humidity levels of the fuel cell ambient. The greater the current density the more divergent the electrical properties are. As such, it is difficult to maintain a useful load current while maintaining a reasonable cell voltage.

FIG. 11 illustrates the same PEM fuel cell operating at 90° C. showing fuel cell voltage V_{FC} versus current density varies parametrically by relative humidity comprising curves 150, 151, 152, 153, 154, and 155 at RH values of 100%, 60%, 35%, 27%, 20%, and 0% respectively. Despite the fact that the cell voltages V_{chem} 156 and V_{eff} 157 remain nearly unchanged from operation at 70° C., the shape of the voltage-current conduction curves with humidity changes substantially. Specifically unlike its lower temperature behavior, at elevated temps (except for 100% humidity curve 150) variation of fuel cell voltage V_{FC} by current density is purely monotonic in both voltage and current with no voltage plateau or knee.

FIG. 12 replots the 70° C. fuel cell voltage against relative humidity varied parametrically by current density with curves 158, 159, and 160 for current densities 0.2, 0.6, and 0.76 A/cm² respectively. Although at low current densities such as 0.2 A/cm² the usable fuel cell voltage increases proportionally with RH, at high current densities the sustained voltage peaks at around RH=55% then declines, likely due to water logging effects such as electroosmotic drag and back diffusion described previously. With the exemplary PEM FC, if the maximum current density is limited, then the usable range of humidity depends on the minimum rated cell voltage.

As shown in the below table if the delivered current is 600 mA/cm² maximum, then to operate at RH≥45% only 0.5V per cell can be ensured. If the maximum guaranteed current is reduced to 200 mA/cm² then 45% humidity can deliver 0.55V. If the minimum guaranteed voltage is lowered to 0.5V, then the fuel cell can work down to 36%. Unfortunately, limiting cell voltages and current to function across a wider range of humidity is not a good tradeoff as atmospheric conductions vary by geography, climate, and altitude.

| Current Density, T = 70° C. | Minimum V_{FC} | Usable RH Range |
|---|---|---|
| 600 mA/cm² | 0.60 V | 100% |
| | 0.55 V | 57% to 100% |
| | 0.50 V | 46% to 100% |
| 200 mA/cm² | 0.60 V | 57% to 100% |
| | 0.55 V | 46% to 100% |
| | 0.50 V | 36% to 100% |

Another major concern is the high internal resistance of fuel cells. Unfortunately, the series resistance of a PEM FC is also highly sensitive to humidity. FIG. 13 illustrates the specific resistance of a PEM fuel cell for various relative humidity levels including curves 165-to-169 corresponding to RH values of 100%, 60%, 35%, 27% in the range of 100-to-800 mΩ-cm². Curve 169 shows resistance at 20% relative humidity is even higher, occurring n the range of 1200-to-1700 mΩ-cm² and limited to current densities below 300 mA/cm².

Specific resistance is the internal resistance of the PEM cell normalized by area. While current density I/A is rated by the current I divided by area A with units either as A/cm² or mA/cm², specific resistance is a measure of the resistance times the area having units of mΩ-cm². The best technologies offer the lowest [R_{FC}A] multiplicative product, allowing to trade off cost and performance. To calculate the resistance of a fuel cell of active area A, the resistance R_{FC} is given by

$$R = \frac{[ {R}_{FC} A ]}{A}$$

where [R_{FC}A] is the technology dependent specific resistance of the fuel cell typically expressed in units of Ω-cm² or mΩ-cm². The brackets surrounding the term [R_{FC}A] indicate the variable is the name of a single parameter, not an equation. This relationship is derived from equations relating material properties resistivity ρ in Ω-cm or conductivity σ in S/cm to the geometry of a conducting medium, in this case the net thickness L of fuel cell membrane and its catalyst layers, i.e. the thickness of the MEA3. For current flowing perpendicular to a membrane surface of area A, the resistance of a single fuel cell can be expressed as

$${R}_{FC} = \frac{{ρ}_{FC} L}{A} = \frac{L}{{σ}_{FC} A}$$

Rearranging terms yields the expression for specific resistance [R_{FC}A].

$$[ {R}_{FC} A ] = {ρ}_{FC} L = \frac{L}{{σ}_{FC}}$$

The term in bracketed to denote the value represents a single number characterizing electrical properties, not a product of two terms. For convenience we define a unit-area fuel cell to have an active area of A_{FC}≡1 cm² where the total area of a fuel cell is given by this area time the unitless multiplier m, so the active area A_{active}=mA_{FC}=m(1 cm²). In this manner the notation nsmp is a simple way to know the geometric design of a fuel cell. For example, a 5s120p fuel cell comprises a stack of n=5 series connected fuel cells each of an area of 120 cm², i.e. A_{active}=120A_{FC}=120(1 cm²).

Using this lexicography, the net resistance of a fuel cell stack can be simply expressed in terms of the fuel cell characteristic specific resistance [R_{FC}A] and the geometric factors n and m as given by

$$R = ( \frac{n}{m} ) \frac{[ {R}_{FC} A ]}{{A}_{FC}} = ( \frac{n}{m} ) \frac{[ {R}_{FC} A ]}{1 {cm}^{2}}$$

For example for the aforementioned 5s120p stack, a fuel cell technology with a specific resistance of [R_{FC}A]=1200 mΩcm² or 1.2 Ωcm² will result is a net FC resistance of R=5·1200/120=50 mΩ. This calculation highlights the fact that even large area fuel cells are highly resistive compared to a lithium ion battery. The components of resistance in a fuel cell are complex including membrane resistance, contact resistance, electrode resistance, and diffusion resistance along with the topological ratio (n/m) representing the ration of the number of cells connected in series divided by the number of 1 cm² cells connected in parallel or the equivalent area. Unlike the lithium ion battery whose resistance is dominated by the ohmic resistance of its conductive electrodes, fuel cell conduction is dominated by the real component of the membrane impedance, i.e. Re {Z_{memb}}.

Unfortunately, this resistance depends strongly on relative humidity of the anode, on relative humidity of the cathode, on temperature, and at low gas flow rates on the gas velocity flowing across the membrane. Of these effect humidity is the most important factor. While water vapor can be added into the hydrogen fuel supply, the cathode oxygen flow is generally supplied by filtered room air. As such, the humidity present in the cathode is beyond the control of the fuel cell system unless active humidification is included. Humidification however requires power and thereby reduces the net efficiency of the fuel cell as a energy converter.

Referring again to FIG. 13, specific resistance is inversely proportional to relative humidity, where 100% RH curve 165 is less than one-third the resistance of the 27% curve 168. As discussed, the membrane resistance is really an electrical representation of the electrochemical process occurring within the MEA. As depicted, specific resistance [R_{FC}A] of the fuel cell decreases with increasing current, mechanistically explained by a more complete electrochemical reaction is occurring and because more water is produced at higher currents. In fact, inflection in the resistance curves above 0.3 A/cm² occurs because of enhanced water production.

The biggest problem of the hydrogen fuel cell is its intrinsically high membrane resistance. For a 1 cm² active area, the fuel cell resistance R_{FC} ranges from 300 mΩ to 1200 mΩ. For the same area lithium ion battery the resistance is between 4 mΩ and 12 mΩ depending on the cell design. As such, the fuel cell resistance is between 10×-to-75× higher than a comparable area Li-ion battery. The high resistance technologically prohibitive for delivering current spikes, rendering conventional PEM fuel cells unusable in most real world applications.

Unfortunately, the resistance disadvantage can be much worse than 75 times. This is because of the low, almost unusable, voltage of a single fuel cell. As described previously, even though today's fuel cells exhibit a maximum chemical potential of 1 V, as described previously even low levels of current demand drop the cell voltage substantially typically to 0.7V or below.

To cover but a modest range in relative humidity, the cells can only be counted to deliver between 0.6V-to-0.5V depending on the humidity. Referencing this voltage to the ubiquitous 3.7V Li-ion cell, and equivalent voltage stack of fuel cells requires 5-to-8 stacked membranes with resistances as high as 8·900 mΩ=7200 mΩ, i.e. 7.2Ω. Compared to the same area lithium ion battery at equivalent voltages, it means the series resistance of conventional PEM fuel cells compared to a nominal 18650 Li-ion battery is (7.20/4mΩ)=18.00× higher.

FIG. 14 illustrates the measured voltage-current relationship of a 4s stack of fuel cells of 1 cm² in area, i.e. where m=1. The curve reveals that although the stack exhibits a voltage 195 of nearly 3.8V at low currents, the voltage 196 drops rapidly to under 3V at only 25 mA/cm². This behavior means the fuel cell is incapable of charging a single cell lithium ion battery.

The other problem is in region 197 there is no condition of stable voltage or a plateau in which stable system operation can be achieved. Instead the voltage declines linearly with a slope of 1.20 meaning the cell has a specific AC resistance of 1200 mΩcm². At 150 mA/cm² the voltage has declined 0.56 V/cell. Voltage sag worsens in region 198 reaching 0.45 V/cell at 200 mA/cm². This voltage is considered a lower limit for reliable fuel cell operation, beyond which the cell voltage plummets. The other problem with a PEM fuel cell is its voltage-current characteristics exhibit a non-monotonic response to changes in humidity, whereby a decrease in relative humidity can cause the polarization voltage of the cell to drop at some current densities and climb at others.

The electrical characteristics of a PEM fuel cell worsen at higher current densities, and especially in cold dry air. In conclusion present day PEM H₂ fuel cells faces numerous unresolved challenges, especially the need to improve their efficiency, reproducibility, and usability by reducing voltage sag, lowering electrical resistance, and minimizing humidity dependence. Its properties are summarized in the following table:

Other fuel cell issues include poor humidity cycling reliability and lack of consistent manufacturing processes. What is needed is a more robust ion exchange membrane able to produce good electrical performance consistently and reliably operate over a spectrum of environmental conditions including changing temperature and humidity. In the absence of such improvements, the commercial adoption is doomed to failure.

| Fuel Cell Advantages | Fuel Cell Disadvantages |
|---|---|
| Generates electricity | Low current, high |
| (limited only by fuel) | resistance |
| No charging required | Poor on-demand power capability |
| Fuel resupply | Not pluggable, unable to |
| increases kWh | refresh from charger |
| FCEV has unlimited | No energy recovery |
| driving range (refueling) | (no regenerative braking) |
| Lightweight | Humidity sensitive, especially in dry air |
| Stackable to high voltages | Poor cold performance |
| No thermal runaway | Central stack single-point |
| | failure system risk |

The targeted improvements require a complete reengineering of the ion exchange membrane whether for cation conduction (a new PEM membrane) of for anion conduction (a new AEM membrane). Other important developments include PEM and AEM membranes useful in hydrogen electrolysis and for medical applications such as kidney electrodialysis along with the need for new fuel cell membranes applicable for alternative noncombustible fuels including glucose.

### Summary of Fuel Cell Deficiencies.

Major deficiencies of fuel cell membranes involve
Poor structural support of thin membranes during manufacturing leading to film damage and latent reliability failure mechanisms.
Poor mechanical support of ion exchange membranes during operation leading to swelling, water logging, stress, and film deformation.
Inability to reduce ionomer thickness without causing incomplete polymerization.
Inability to precisely and reproducibly control film porosity.
Inability to suppress swelling and shrinkage of ionomer films with humidity and temperature cycling.
Inability to prevent fuel crossover and the damaging consequences therefrom.
Inability to efficiently and uniformly graft hydrophilic ionomers such as PFSA onto hydrophobic backbones such as PTFE.
Inability to manufacture ion exchange membranes using automated or semi-automated manufacturing including dispersion cast molding, firm handling, chemical treating, and catalyst layer coating.
Inability to consistently form catalyst layers on ion exchange membranes free from adsorbed surface contaminants and interfacial states.
Inability to reduce the material and manufacturing cost of catalyst layers formed on ion exchange membrane.
Poor interfacial contact between gas diffusion layers and catalyst layers in a fuel cell.
Incompatibility of manufacturing both proton exchange membranes and anion exchange membranes using a common manufacturing process and shared or repurposed processing equipment.
Incompatibility of manufacturing ion exchange membranes for both fuel cell and hydrogen electrolysis application using a common manufacturing process and shared or repurposed processing equipment.
Poor suitability of present day ion exchange membranes for producing airplane safe fuel cells comprising noncombustible fuels such as glucose.
Incompatibility of manufacturing ion exchange membranes for both hydrogen fuel cell and glucose fuel cells using a common manufacturing process and shared or repurposed processing equipment.
Inability to reduce the effects or relative humidity on ion exchange membrane electrical conductivity and power outputs.
Inability to ameliorate the adverse reliability impact of humidity cycling on ion exchange membranes.
Excessive heating and power loss in centralized large-stack fuel cell architectures.
Limited durability and cycle life challenges.
Lack of redundancy and susceptibility to single-point failures in present-day fuel cell stacks.
Excessive thickness in high-voltage fuel cell stacks.
Inability to adequately cool present day fuel cell stacks.
Inability to avoid handling induced damage to the fuel cell membrane during manufacturing.

### SUMMARY OF THE INVENTION

A new class of ion exchange membranes (IEMs) made in accordance with this invention includes a chemically inert electrically inactive semi-rigid skeletal structure interspersed with electrically conductive ionomers which may comprise a proton exchange membrane (PEM) for specific conduction of positive ions, i.e. cations such as hydrogen ions, or may comprise an anion exchange membrane (AEM) selectively conducting negatively charged ions. In one embodiment the structure skeleton forms a grid or waffle-like pattern with a thin ionomer [FIG. 24], e.g. between 50-to-20 μm in thickness filling the window panes in the waffle pattern.

Unique advantages of the inventive inert skeletal structure comprise:
polymeric membranes with improved mechanical strength during handling in manufacturing reducing tearing, ripping, or the formation of latent damage zones impacting yield, membrane leakage, and long term reliability of the film including a mechanical frame for robotic or mechanical clamping [FIG. 18A, FIG. 18B, FIG. 73];
an array of multiple polymeric IEM membranes integrated into a single polymeric sheet [FIG. 24, FIG. 25, FIG. 27] comprising multiple islands of active ionomeric membrane delineated by a rectilinear array of inert pillars forming a mechanically supporting skeleton, and subsequently separate them into individual membranes of defined size and active areas;
a grid-like skeletal structure of inert pillars supporting panes of thin ionomeric membranes where the spacing of the inert pillars reduce sagging of the ionomeric membrane [FIG. 16B]during manufacturing and handling of the membrane;
a grid-like skeletal structure of inert pillars supporting panes of thin ionomeric membranes where the pillar include fillers of carbon fiber, plastic shards, carbon nanotubes, or other quasi-rigid materials [FIG. 42] able to enhance the mechanical strength and rigidity of the membrane to improve handling and reduce handling damage;
a grid-like skeletal structure of inert pillars supporting panes of thin ionomeric membranes where the pillars comprise at least two widths [FIG. 21, FIG. 24], the wider of which define individual membranes in a single polymeric sheet containing multiple IEM membranes [FIG. 25, FIG. 26], and where the wider inert pillars are used to perform singulation of the single multi-IEM array into separate individual IEMs using sawing or laser cutting [FIG. 47, FIG. 74];
a beneficial reduction in the lateral swelling and contraction of the ionomeric membrane [FIG. 17] with varying hydration levels in the membrane's plane reducing in-plane stresses and stress related failure from temperature cycling, humidity cycling, and power cycling;
a beneficial reduction in orthogonal swelling and contraction of the ionomeric membrane [FIG. 17] with varying hydration levels minimizing transverse stresses and stress related failures from temperature cycling, humidity cycling, and power cycling;
the ability of the inert skeletal matrix from preventing lateral mitigation and seepage of acids and ionic liquids [FIG. 422A, FIG. 422B, FIG. 425] across the membrane and escaping from the membrane's periphery.

In another embodiment the skeletal pattern comprises temperature and pressure molded polytetrafluoroethylene (PTFE) or other polymers such as thermoplastics or polyolefins [FIG. 21] optionally strengthened by a fibrous filler to increase the membrane's mechanical strength including carbon fiber, graphene, carbon nanotubes, or rigid polymer shards including various plastics [FIG. 22]. The reinforcing filler within the support filler may be fully enclosed, i.e. encased, in an inert material such as PTFE or other compounds with completely-bonded, i.e. inert, surface atoms. In addition to resilience to acids the pillars comprising the skeletal structure may be hydrophobic to avoid interfering with the ionomeric film.

Aside from polytetrafluoroethylene (PTFE), candidates for pillar coatings include polyether ether ketone (PEEK), polyvinylidene fluoride (PVDF), ethylene tetrafluoroethylene (ETFE), perfluoroalkoxy alkane (PFA), polyphenylene sulfide (PPS), polyimide (PI), polyamide-imide (PAI), fluorinated ethylene propylene (FEP), polybenzimidazole (PBI), polyetherimide (PEI), polyethylene naphthalate (PEN), polyetherketone-ketone (PEKK), polydiallyl phthalate (PDAP), polysulfone (PSf, PSU), polyphenylene sulfide (PPS), liquid crystal polymer (LCP), and polyaryletherketone (PAEK).

In another embodiment the ionomer bonds to the skeleton either directly or though an intervening adhesion promoter. For example the chemical bond between a hydrophobic PTFE skeleton and a hydrophilic PFSA [FIG. 23], i.e. perfluorosulfonic acid, can be enhanced using PVA poly(vinyl alcohol), a water-soluble synthetic polymer as an intermediary. Benefits of the disclosed skeletal supported IEM include preventing handling induced damage during manufacturing and assembly, improved planarity and reduced sagging [FIG. 16B] of thin ionomers, reduced membrane swelling [FIG. 17], enhanced reliability for temperature cycling, and superior reproducibility in electrical conductivity.

In another embodiment the cross linking adhesive bridging the ionomeric membrane to the membrane's skeleton or support pillar must be contain the right combination of polar and non-polar functional groups. For example if the exterior coating of skeletal support [FIG. 429D. 429G] comprises a polar polymer or plastic such as polyamide (PA), polycarbonate (PC), polymethylmethacrylate (PMMA), and acrylonitrile butadiene styrene (ABS), then the cross linker must include a chemically reactive polar group to facilitate bonding to the skeleton. Conversely in another embodiment if the exterior coating of skeletal support comprises a non-polar polymer plastics such as polypropylene (PP), polyethylene (PE), styrene ethylene butylene styrene block copolymer (SEBS), polystyrene (PS), and polytetrafluoroethylene (PTFE) then the cross linker must include a chemically reactive non-polar group to facilitate bonding to the skeleton.

Exemplary embodiments of cross linkers between the polymer membrane and skeletal pillars used in accordance with this invention include glutaraldehyde (GA); sulfonated glutaraldehyde (sGA); glyceraldehyde; formaldehyde; divinyl benzene (DVB); epichlorohydrin (ECH), p-hydroxymethyl benzyl chloride (HMe-BnCl), divinyl benzene (DVBz); and dibenzoyl peroxide (DBPO); 2-dihydro-4-(4-hydroxyphenyl)-1 (2H)-phthalazone (DHPhthal); peroxide (H₂O₂); dithiol (DT), dithiol (DT), bishydroxy perfluoropolyether (PFPE); sodium borohydride (NaBH); bis(hydroxymethyl) (CH₃O); N,N-dimethylformamide (DMF); N,N-dimethylacetamide (DMAc); N-methyl pyrrolidone (NMP); and biphenyl A (BPA), benzene (Bz); benzyl alcohol (BnOH, cresol); perfluorodibenzoyl peroxide ((FBzO)₂, FBzO), perfluoro-di-tert-butyl peroxide (FDTBO); perfluoro-dimethyl-dioxolane (PFDMO); p-hydroxymethyl benzyl chloride (OHMe-BnCl); 4,4′-trimethylene bis(1-methylpiperidine) (BMP); photo-induced 2,4,6-trimethyl benzoyl-diphenyl-phosphine oxide (photo TPO); trimethylolpropane tri-acrylate (TMPTA); and E-caprolactam (CPL, (CH₂)₅CNH).

Other cross linkers used in accordance with this invention include sulfonamide (SAm); anhydrous aluminum chloride (AlCl₃); trichlorobenzene (TCB); hydrous calcium sulfate (CaSO₄·2H₂O); sulfamic acid (HSO₃ (NH₂)); benzoyl peroxide (BPO, (BzO)₂); tert-butyl peroxypivalate (tBPPiv); thiol-containing chain transfer agents (CTAs); dithiol (DT), sulfonated dithiol (SDT); 4,4′-trimethylene bis(1-methylpiperidine) (BMP); trimethylolpropane tri-acrylate (TMPTA); phenyl (Ph); methylated phenyl (MePh); α,α′-dibromo-p-xylene (DBpX or PhBr₂); 1,3,5-tris(bromomethyl)-2,4,6-triethyl benzene (BeBr₃); p-xylylene dichloride (PhCl₂, C₈HCl₂); divinyl sulphone ((CH₂=CH)₂SO), 1,3,5-tris-(bromomethyl)benzene (B₃Br); benzoxazine (C₁₄H₁₃NO), hexachlorocyclotriphosphazene HCCP; imidazolechlorocyclotriphosphazene (ImCCP); polyoctahedral silsesquioxanes (X-L) POSS); and sulfate anion groups (SO₄⁻). Hexafluoropropylene oxide (HFPO) may be used for temporary bonds.

In other embodiments of this invention, acid and/or bases form cross linking between ionomer to skeletal pillars. Examples include citric acid (C₆H₅(O₇)³⁻); acetic acid (AcOH), glycolic acid (C₂H₄O₃), ethyl lactate (Acytol™, lactic acid, C₅H₁₀O₃), pyruvic acid (Pyr, C₃H₄O₃), butyric acid (C₃H₇COOH); sulfuric acid (H₂SO₄, SA); hydrochloric acid (HCl); strong bases such as sodium hydroxide (NaOH) or potassium hydroxide (KOH); Lewis acids comprising metal salts such as aluminum chloride (AlCl₃) or zinc chloride (ZnCl₂); and carboxylic acids; i.e. acids containing carboxyl (—COOH) functional groups such as formic acid (methanoic acid, HCOOH), and carbonic acid (hydroxymethanoic acid, H₂CO₃); along with quaternary ammonia compounds including 1,4-diazabicyclo-[2.2.2]-octane (DABCO), quinuclidine, and quinuclidinol. Heat and ultraviolet light can also promote cross linking between and among homopolymer and heteropolymer chains.

Although ion exchange membranes necessarily contain polar groups as ionomers for controlling conduction, the spine of the membrane, i.e. the mainchain of the polymer may be polar or non-polar. In one embodiment, the cross linker includes non-polar functional groups able to bond onto a non-polar mainchain of the polymer. In another embodiment the cross linker is polar and able to bond onto either a polar polymer mainchain or onto the polar ionomers. Bonding onto the polar ionomers however has the disadvantage of reducing isomeric conductivity by reducing the density of electrically active ionomers.

In another embodiment, the skeletal support structure includes an endoskeleton and an exoskeleton where the endoskeleton defines the internal frames supporting the ionomer and the exoskeleton defines the external dimensions of the IEM [FIG. 24]. In another embodiment, the exoskeleton is wider then the endoskeleton to accommodate cutting by a laser during singulation of the IEM [FIG. 26] from a membrane matrix containing one or many IEMs arranged in multiple columns, rows, or both.

In another embodiment, the membrane matrix includes a thicker wider outer portion referred to as a frame to facilitate handling by robotic or mechanical handling machines. In a related embodiment, the outer frame of the matrix is thicker than the exoskeleton. In one implementation the thick outer frame merges laterally into the exoskeleton [FIG. 28] while in another implementation the outer frame and the exoskeleton are separated by a gap except in specific locations where a tie bar connects the two elements [FIG. 24]. In another embodiment the thick frame border of the matrix is centered in the plane of the membrane while in another implementation the frame is offset from the membrane plane [FIG. 20]. In one embodiment of the frame centered on the membrane a temporary block called a handle is used during catalyst deposition to support the membrane.

Made in accordance with this invention, fabrication of a membrane frame, exoskeleton, endoskeleton, and ionomer [FIG. 19, FIG. 28] comprises a process sequentially or concurrently forming a thick matrix frame comprising various features including a frame, an exoskeleton and endoskeleton, and a thin electrically active ionomer. The membrane frame may contain one or multiple IEMs [FIG. 27] arranged in an array of rows, columns, or both. In one embodiment of this invention, the matrix frame and skeletal structure is formed either sequentially or concurrently [FIG. 32], and thereafter followed by ionomer fabrication and where the pattern and volume of the mold cavity is varied to define the location, vertical height, and lateral locations [FIG. 32] of the frame, skeleton, and ionomeric membrane.

In one embodiment, the thicknesses of the various elements of the membrane matrix are adjusted by using a mold chase inserted into the cavity of a mold press [FIG. 61] limiting the volume of the mold chamber and defining the features of the membrane matrix [FIG. 36]. Alternatively, polymerized features of a membrane matrix remaining in the mold chamber may define the locations where the mold compound is present during subsequent pressure and temperature mold pressing [FIG. 36]. Elements may be held together by HFPO until full polymerization occurs,

A mold chase may be inserted into a bulk mold chamber to define the specific dimensions of one or more of the four elements of the membrane matrix for molding [FIG. 30]. After molding a particular feature, the original mold chase may be removed and replaced with a new mold chase inserted to change the depth and location of features in a subsequent molding process. During the mold change, the polymerized mold compound of the membrane matrix may remain in the mold or be removed and reinserted into the mold following a change in the inserted mold chase. In some instances, the partially fabricated membrane matrix may be inverted [FIG. 33] before reinsertion into the modified mold chase.

During the molding process, the shape of the effective mold chamber may be changed by removing the mold chase and replacing it with a different mold chase between molding steps. Alternatively a two-or-three layer mold chase [FIG. 58] may be inserted into the mold cavity and then partially removed in succession [FIG. 60, FIG. 62] during a sequence to change the effective volume and shape of the mold cavity and to define various features of the membrane matrix. In one implementation a tri-layer mold chase comprising a top, middle, and bottom feature whereby the first matric feature is first inserted into the mold chamber followed by molding of a portion of the matrix. After molding the top portion of the tri-layer mold chase is removed [FIG. 60] while the middle and bottom layers of the mold chase remain along with the partially molded membrane matrix.

In another embodiment, the composite ionomer membrane is molded without removing the skeletal matrix element previously polymerized [FIG. 61]. After the second molding operation, the middle portion of the mold chase may be removed with only the bottom portion of the mold chase remaining in the mold chamber. After removing the middle mold chase, a third molding operation is performed with only the bottom mold chase remaining [FIG. 62]. In one exemplary process flow the third molding step forms the ionomer film filling the spaces between the pillars of the skeletal matrix and subsequently polymerized by pressure and/or heat applied by the mold press [FIG. 63]. In the disclosed process sequence of molding, the various polymerized components of the membrane matrix overlap [FIG. 65, FIG. 57] joining together to form a single membrane matrix.

In various embodiments of this invention, a membrane matrix comprising a frame and skeleton may be formed by loading, transferring, casting, or injecting a mold compound into a mold comprising a solid powder or liquid suspension. After loading the mold, a heated press activates polymerization of the mold compound in order to form and harden the membrane matrix using a process referred to as dispersion casting. Polymerization by sequentially or concurrently applying elevated pressure and/or elevated temperatures. In the case of sequential molding, separate polymerization steps are used to form first form the matrix frame, then the skeletal support matrix, and finally the active ionomer. Alternatively the pillars can be co-molded with the membrane.

In an inventive embodiment involving concurrent molding [FIG. 31, FIG. 32], the matrix frame and support skeleton are molded simultaneously followed by the ionomer formation. The supports structure comprises a mold compound consisting of PTFE or other non-conductive polymers such a plastic shards [FIG. 22]. In one version involving dispersion casting, finely powdered PTFE grains are loaded into the mold and compressed to a high pressure between 10-to-100 MPa then heated to 360° C. to 380° C. to sinter the powder into a single polymerized mass. The addition of carbon fiber, graphene, carbon nanotubes, or polymeric shards provides added mechanical strength and support to skeletal pillars [FIG. 429D, FIG. 429G]. The support filler may be encased in a polymer coating compatible with the membrane to minimize mismatch and stress resulting from differences in the temperature coefficient of the support pillar and the membrane chemistry.

In another embodiment the mold comprises different depth features to form a matrix frame having a height greater than the skeleton. Differences in height of the fiber-reinforced quasi-rigid matrix frame and skeleton can cause film stress. A gap between the two rails provides stress relief whereby the matrix of IEMs is held in place by regularly spaced tie bars circumscribing the membrane array [FIG. 25, FIG. 52]. In one embodiment, the membrane is coplanar with the bottom or top edge of the support pillar or skeletal column [FIG. 27]. In another embodiment the membrane is located substantially in the middle of the vertical column [FIG. 56].

In yet another embodiment, a process sequence with three molding steps involves first fabricating the membrane matrix frame [FIG. 59], changing the mold or removing a portion of a multi-layer mold chase, then concurrently molding the exoskeleton and endoskeleton [FIG. 61]. Thereafter the mold chase is replaced or a portion of portion of a multi-layer mold chase is removed and the thin ionomeric membrane is pressure molded [FIG. 64]. In an alternative flow using two molding steps, the matrix frame and skeleton are concurrently molded [FIG. 32] followed by removing the mold chase, inverting the membrane [FIG. 33] then pressure molding the ionomeric membrane [FIG. 35, FIG. 36] with sequential or concurrent thermal annealing of the polymerized ionomer [FIG. 37]. Regardless of whether the frame and skeleton are fabricated concurrently or sequentially, these structural support elements may comprise a polymer such as PTFE [FIG. 21] or be combined with a supportive filler [FIG. 22] such as carbon fibers, graphene, carbon nanotubes, or rigid polymer shards.

In contrast to present-day commercially available PEM membranes which lack structural support, the inventive membrane matrix made in according with this invention provides mechanical rigidity thereby preventing tearing or film damage from handling leading to yield loss, product cost increases, and latent reliability failures. In one embodiment, the membrane matrix includes a thick frame circumscribing a matrix of IEMs where the frame is used for mechanical holding of the matrix during manufacturing by mechanized handlers or robotic arms and clamps [FIG. 20, FIG. 45, FIG. 72]. The inventive frame provides superior mechanical rigidity during post molding processing prior to IEM singulation [FIG. 19], including chemical treatments to the membrane, attaching or detaching support handles, cleaning, and rinsing.

The matrix frame optionally provides support during catalyst formation, especially in processes using the attachment of decal laminate catalyst layers. One unique advantage of the matrix frame is it delays the need to singulate [FIG. 54] the IEMs until later in the process, especially not until after gas diffusion layers are attached [FIG. 46, FIG. 53, FIG. 72, FIG. 73]. Clamping the matrix frame can also provide support during laser singulation [FIG. 47, FIG. 74]. This benefit means the carbon paper based GDL layers [FIG. 47, FIG. 74] need not be attached to separated IEMs one-by-one but can be attached to an entire membrane matrix comprising multiple IEMs in one process step for the cathode side of the CCM and another for the anode side.

In one embodiment, a membrane matrix contains five or more IEMs [FIG. 53]. Prior to singulation only two process steps are required to attach sheets of anode and cathode GDLs to all five IEMs each, rather than involving ten separate processes—five anode attachments plus five cathode attachments. If a membrane matrix contains 50 IEMs, prior to singulation attachment of GDL sheets to all fifty IEMs still requires only two operations. By contrast, if the GDLs are attached after singulation, 100 separate operations are required. As such, a significant benefit of the inventive frame for handling and skeletal support [FIG. 54] is it enables IEM fabrication to benefit from “batch processing,” analogous to batch wafer processing responsible for enabling the silicon semiconductor revolution. Moreover, by attaching the GDL sheets to an entire membrane matrix, bonding uniformity, contact resistance, and film reliability are greatly enhanced over discrete assembly methods.

As another embodiment of this invention, the design of a membrane matrix and frame using tie bars to support the exoskeleton, holding it in place during laser cutting greatly simplifies the singulation process [FIG. 54] whereby the vertical cut lines can be made first without losing support until the very last step when the two horizontal cuts are made completing the singulation process. [FIG. 55].

In one embodiment made in accordance with this invention, an ionomer is formed in a membrane matrix [FIG. 24] by loading the mold with an ionomeric mold compound filling the available cavities between skeletal pillars. The mold compound may be filled to a height approximately equal to the height of the inert pillars or slightly thicker [FIG. 34, FIG. 62] followed by the controlled application of pressure [FIG. 35, FIG. 36, FIG. 63] and heating [FIG. 37, FIG. 64] to activate cross linking and polymerization of the monomers, binding the ionomer to the skeletal pillars [FIG. 28, FIG. 38, FIG. 57, FIG. 65].

In some embodiments, the molded ionomer may comprise a bulk conduction ion exchange membrane such as a pure PFSA polymer or alternatively may comprise a surface conducting ionomer such as a PFSA coated PTFE matrix [FIG. 19, FIG. 23] also referred to as a composite reinforced membrane (CRM). Unlike conventional CRMs lacking skeletal structural support, however, the PTFE content by weight percentage need not be significant as mechanical strength of the membrane does not rely solely on the conducting film but on lateral support of the skeletal pillars. As such, the inventive ionomer need not involve a compromise between conductivity and film strength as it does in conventional CRM ionomers.

Made in accordance with this invention, the ionomer may be formed using a powdered ionomer or by soaking the ionomer in a solvent or molecular glue such as PVA before molding [FIG. 77A]. In one process used to form a proton exchange membrane, PTFE is molded or extruded into a non-conductive film then treated by an adhesion promotor such as PVA solution at an elevated temperature, e.g. 90° C. sufficient to promote molecular grafting without damaging the PTFE backbone. In one embodiment, a solution of a PFSA ionomer dissolved in a reagent such as hydrogen peroxide and iron(II) sulfate heptahydrate also known as “Fenton's reagent” is used as a catalyst to create free radicals and promote bonding (aka grafting) between the PFSA and PTFE molecules, followed by glutaraldehyde solution to activate cross linking in the pristine PFSA matrix. The slurry in then heated under pressure to encourage bonding between the preformed PTFE matrix and the PFSA monomers during polymerization.

After formation of the ionomer, in some embodiments the membrane is chemically treated with reagents, solvents, or boiling in deionized water. In one embodiment, the molded film may be sprayed with PTFE nanoparticles [FIG. 77A] to control the surface reactivity of the membrane. The combination of polytetrafluoroethylene (PTFE) nanoparticles with a perfluorosulfonic acid (PFSA) membrane can result in several beneficial effects on fuel cell operation, including
Improved Water Management. PTFE is hydrophobic, which means it repels water. By coating the PFSA membrane with PTFE nanoparticles water management within the fuel cell is improved preventing excessive water accumulation, which can lead to “flooding” of the membrane. The coating thereby maintains an optimal level of hydration for the membrane, improving proton conductivity while reducing the risk of performance degradation.
Enhanced Durability. PFSA membranes can degrade over time due to mechanical, thermal, and chemical stresses. The addition of PTFE nanoparticles increase the mechanical strength and chemical resistance of the membrane, leading to improved durability and a longer lifespan for the fuel cell.
Reduced Crossover. PTFE's hydrophobic properties reduces crossover of fuel, such as hydrogen or methanol transiting through the membrane. The coating thereby improves the fuel cell efficiency by minimizing fuel losses, reducing heating, and combatting catalyst poisoning in the cathode.
IL Leakage. PTFE nanoparticles and nanocoating [FIG. 106, FIG. 107, FIG. 422C, FIG. 423] prevent leakage of ionic liquids or acids from the membrane into the gas diffusion layer and leaking into the surrounding assembly possibly causing corrosion of metals used in the assembly.
Membrane Poisoning. PTFE nanoparticles and membrane nanocoatings [FIG. 106, FIG. 107, FIG. 422C, FIG. 423] when combined with carbon, carbon nanotubes, silicates, metal organic framework (MOFs) with scavenger metals, nanofibers, zeolites, zirconia, polyoctahedral silsesquioxanes (POSS), and optionally with boron nitride particles reduce diffusion of airborne contaminants such as carbon monoxide protecting catalysts and ionomer acid groups from poisoning and damage.

In another class of embodiments made in accordance with this invention, the ionomer matrix is infiltrated with a sacrificial filler, intercalated within the film during molding or dispersion casting to create pores in the molecular matrix [FIG. 429I, FIG. 430], where the sacrificial filler is removed subsequent to polymerization. Requirements for the sacrificial filler is its ability to disrupt the normal periodicity of the polymeric matrix thereby reducing the equivalent weight of the polymeric matrix, and that it can be removed in a subsequent process using deionized water or a solvent that does not disrupt or damage the polymerized matrix including the PTFE backbone, pendant sidechains, and PFSA ionomers. In one class of embodiments, pores created by the sacrificial filler process comprise atomic voids larger than natural pores within the polymeric matrix [FIG. 429I]. In other embodiments the sacrificial filler process is combined with a process to introduce permanent fillers into the polymeric matrix [FIG. 429I, FIG. 429K, FIG. 429L] or formed prior to the introduction of ionic liquids into the membrane after the sacrificial filler process for sac pore formation is complete [FIG. 429M].

In one embodiment the sacrificial filler is sugar [FIG. 82] and the solvent is water. In another embodiment pores created by sacrificial filler process are filled with pools of ionic liquids in greater amounts than IL concentrations residing interstitially or in natural nanopores [FIG. 429F, FIG. 429M, FIG. 430]. In various embodiments of this invention the sugars may comprise varying size molecules such as sucrose, glucose, fructose, or lactose creating nanopores or micropores of varying dimensions. In. one embodiment, the concentration of filler loaded into the mold is used to control the density of the sacrificial pores. Benefits of the sacrificial filler process include enhanced charge transport, higher conductance [FIG. 96A, FIG. 96D], higher conversion efficiency [FIG. 96E], increased power output [FIG. 96D, FIG. 97] and reduced power loss and waste heat generation [FIG. 96F, FIG. 96G].

In other embodiments made in accordance with the invention, three different representative processes [FIG. 81] are employed to form a porous membrane. These inventive processes include (i) mixing a dry sacrificial filler powder with the ionomer monomer and loading the dispersion into a mold, or (ii) dissolving a sacrificial filler and ionomer monomer into a solution and loading the slurry into a mold, or (iii) loading a sacrificial filler into the mold and forming a semi-crystalline template onto which a ionomeric solution is applied and allowed to soak into the template followed by polymerization and curing.

Regardless of which process is employed, the resulting polymerized matrix is then rinsed in either water or solvent to remove the sacrificial filler leaving a polymeric matrix with artificially formed pores larger or in higher density than natural pores present in a untreated pristine polymers. For example, sucrose can be introduced into a PFSA, PFSA-PTFE, glassy matrix, hydrocarbon, or biopolymer blend of monomers and additives prior to polymerization and be subsequently removed with deionized water one the membrane is formed to produce a ionomer with enhanced porosity [FIG. 422A]. After the sacrificial filler is removed the ionomer is baked, i.e. thermally annealed [FIG. 19], to chemically stabilize the film prior to applying any catalyst layers. Other materials may be used for forming different PEM or AEM membranes. In general, the physical mechanism to form sacrificial pores in an ionomeric polymeric membrane made in accordance with this invention involves (i) introducing a sacrificial filler into a polymer matrix present during polymerization and (ii) removing the filler after polymerization. In another embodiment, ionic liquids may be introduced into the polymeric matrix subsequent to sac pore formation [FIG. 422B] then sealed by a nanocoating [FIG. 422C, FIG. 423]. One such process sequence involves the casting or dispersion molding of the ionomeric film containing ionomer monomers, sacrificial fillers, and permanent fillers onto a prefabricated skeletal matrix, followed by solvent removal of the sacrificial filler, optional ionic liquid doping of the film, annealing, and nanocoating [FIG. 424].

After membrane formation, various methods may be employed using a catalyst to enhance electrical activity and improve chemical stability of the film. Application of catalyst layers in producing an IEM is described in a related application “Advanced Fuel Cell—Design, Apparatus, & Fabrication,” referenced herein. In one embodiment, the two catalyst layers are of the same chemical composition but optionally where the thickness of the catalyst layer on the CCM is thinner than the catalyst layer laminated onto the GDL.

In various embodiments, catalyst formation may comprise an amalgamate or mix of carbon and noble metals applied to the membrane as a decal laminate or by painting, spray application, or sputter deposition. On one embodiment, sputter deposition affords the ability to control interfacial states between the catalyst layer and the membrane by including a pre-deposition sputter etching step removing atomic defects and surface contaminants. Since sputter etching involves a mass transfer process to dislodge surface impurities, the cleaning process is agnostic to chemical composition of surface contaminants.

Catalyst deposition is performed sequentially on each side of the membrane matrix, for example first on anode side [FIG. 38, FIG. 68] and then on the cathode side [FIG. 41, FIG. 70] or vice versa. In one embodiment, the membrane matrix is affixed to a handle comprising metal, polymer, or graphite blocks to hold it in place during catalyst deposition. Alternatively, in another embodiment, a support block can be placed at the sputter system's vacuum chuck to rest the membrane matrix atop or the matrix may be held via its frame. The resulting structure after both catalyst depositions is a catalyst-coated MEA3 or CCM [FIG. 42, FIG. 72]. Because the IEMs are bound together in the membrane matrix, the catalyst deposition steps made in accordance with this invention comprise batch processing analogous to semiconductor processing, where multiple IEMs are processed in one step.

In one set of embodiments, the catalyst layers on the anode and the cathode are not identical but have different thicknesses, compositions, or stoichiometries. For example, the anode catalyst layer may comprise platinum or platinum-gold mixed with carbon and PFSA nanoparticles to improve interfacial charge transport. Conversely to enhance oxygen reduction rates, a cathode catalyst layer (CCL) may comprise a blend of platinum and iridium with a palladium interlayer. Alternatively the cathode catalyst layer may include metal oxides such as titanium dioxide (TiO₂), zirconium dioxide, tungsten-oxide-(VI) (WO₃), tungsten-oxide-(II) (W₂O₃), or various metal-organic-frameworks (MOFs). In one class of embodiments, the MOFs include both catalyst metals such as platinum (Pt), palladium (Pd), iridium (Ir), and titanium (Ti) along with scavenger metals such as iron (Fe), cobalt (Co), tungsten (W), and nickel (Ni) beneficially used to sequester atmospheric toxins and pollutants such as carbon monoxide (CO), hydrogen sulfide and other contaminants, either airborne or as a fuel impurity. As another embodiment of this invention, the catalyst layer may include boron nitride nanoparticles impervious to carbon monoxide to reduce the risk of catalyst poisoning.

In another embodiment, in the event of an asymmetric catalyst, i.e. where the anode catalyst layer (ACL) and cathode catalyst layer (CCL) differ, a marker is added to one side of matrix or handle to unambiguously identify the anode catalyst side of the matrix frame [FIG. 18A, FIG. 18B, FIG. 50, FIG. 51, FIG. 54]. The mark may identified by automated visual inspection using red, infrared, UV light, or X-rays, or may involve some other feature or asymmetry in the IEM frame to distinguish the anode and cathode sides of the CCM.

In some embodiments, fabrication of gas diffusion layers [FIG. 95] made in accordance with this invention comprise a heterogenous composition or hGDL including a MPL microporous layer of carbon paper coated with a multi-layer or graded porosity [FIG. 91, FIG. 92, FIG. 93] with the smallest pores adjacent to the MPL and the topmost GDL layer being the most porous. In one embodiment the graded GDL is formed using a multi-head printer [FIG. 90A] where one print head delivers coarse fiber carbon ink, a second delivers medium fiber carbon ink, and a third prints fine carbon fiber ink. In one embodiment the fine ink is printed first followed by the medium and finally a coarse fiber high porosity layer. In another embodiment the print heads scan across the paper while the carbon paper advances under the head assemblies. In yet another embodiment multiple fiber lengths are mixed and in varying blends and printed using a single print head [FIG. 90B]. Subsequently, the fabricated gas diffusion layers are attached to the IEMs.

In one embodiment, the GDLs are attached to the membrane matrix prior to singulation [FIG. 19] including attachment to the CCM on the cathode side [FIG. 44, FIG. 72] and attachment to the CCM on the anode side [FIG. 46, FIG. 72]. Because the IEMs are bound together in the membrane matrix, the GDL attachment steps made in accordance with this invention comprise batch processing analogous to semiconductor processing, where multiple IEMs are processed in one step. In one embodiment the GDLs are attached to the CCM directly with no additional coating on the MPL side of the gas diffusion layer [FIG. 72]. In another embodiment, the MPL side of the GDL is coated with a decal laminate [FIG. 95] of the catalyst layer where the GDL catalyst contacts the CCM catalyst layer [FIG. 94].

After fabrication of the five-layer MEA5 sandwich comprising GDLs and surrounding a central CCM, bipolar plates are attached to supply fuel and reduction agents [FIG. 93] and to conduct current between series connected cells in a fuel cell stack [FIG. 98]. While early generation fuel cells employed thick heavy bipolar layers of steel 6 mm or more in thickness as their bipolar plates, the disclosed invention uses tripolar plates constructed of conductive carbon compounds containing three separate channels—fuel such as hydrogen for the FC anode, a reducing agent such as oxygen delivered to the FC cathode, and a third channel carrying coolant [FIG. 100]. The thickness of the disclosed tripolar plate is reduced to only 1.2 mm, representing a six-fold reduction in fuel cell stack height [FIG. 98, FIG. 99].

In another embodiment, the tripolar plate contains an integrated temperature sensor [FIG. 100], the electrical measurement from which can be used to modulate the operating conditions of the fuel cell [FIG. 101] including controlling hydrogen flow rates, cathode air exchange rates, coolant flow and heat exchange. As such, the intelligent buffered fuel cell (iBFC), can adjust air rates to maintain a specific target temperature internal to the fuel cell [FIG. 102A].

In on set of embodiments the combination of a skeletally reinforced thin microporous ionomeric membrane, e.g. 20 microns thick or thinner, together with a heterogenous graded gas diffusion layer is confirmed to deliver twice the output power for the same waste heat level of fuel cell power dissipation [FIG. 103].

### Ionomeric Membrane Classifications.

Made in accordance with this invention ionomeric membranes comprise molecular matrices where the conductive ionomer is present as ionomeric groups contained within a polymer matrix. In one set of embodiments, ion exchange within the inventive polymer mechanistically involves protonation and deprotonation of immobile anions or immobile cation. In various embodiments, the ionomers attach to the polymer matrix through a variety of means. Depending on the fabrication processes thereof, the polymeric matrix may contain any of the following structures:
ionomers attached to a polymeric backbone via a sidechain or pendant [FIG. 107, FIG. 112, FIG. 119, FIG. 127, FIG. 133A, FIG. 139, FIG. 140, FIG. 142, FIG. 152, FIG. 158, FIG. 183B, FIG. 209A, FIG. 209B, FIG. 213, FIG. 214, FIG. 209A, FIG. 215A, FIG. 215B, FIG. 218 to FIG. 220, FIG. 223, FIG. 245, FIG. 264, FIG. 265B, FIG. 265C, FIG. 352, FIG. 356, FIG. 367A to FIG. 367C, FIG. 384, FIG. 431A to FIG. 431E, FIG. 431H, FIG. 431I, FIG. 431L, FIG. 431R] formed during molding or casting of the membrane;
on-chain ionone present within a polymeric backbone [FIG. 119, FIG. 123, FIG. 129, FIG. 130, FIG. 131, FIG. 135A, FIG. 137, FIG. 139, FIG. 141, FIG. 149, FIG. 150, FIG. 154, FIG. 155, FIG. 161 to FIG. 169, FIG. 171 to FIG. 179, FIG. 181B, FIG. 182B, FIG. 184, FIG. 202, FIG. 214, FIG. 215A, FIG. 215B, FIG. 221, FIG. 230, FIG. 233B, FIG. 382, FIG. 133A, FIG. 385A to FIG. 385C, FIG. 386, FIG. 431A, FIG. 431B, FIG. 431E, FIG. 431G, FIG. 431H, FIG. 431J to FIG. 431N] formed during molding or casting of the membrane;
ionomers formed within a cyclic ring within or attached to a polymeric backbone or a polymer matrix [FIG. 116, FIG. 129, FIG. 130, FIG. 131, FIG. 135A, FIG. 135B, FIG. 137, FIG. 139, FIG. 140, FIG. 141, FIG. 142, FIG. 145, FIG. 146, FIG. 147, FIG. 148, FIG. 149, FIG. 150, FIG. 151, FIG. 152, FIG. 154, FIG. 155, FIG. 161 to FIG. 169, FIG. 171 to FIG. 179, FIG. 181B, FIG. 182B, FIG. 184, FIG. 202, FIG. 214, FIG. 215A, FIG. 215B, FIG. 218 to FIG. 220, FIG. 221, FIG. 223, FIG. 226A, FIG. 226B, FIG. 230, FIG. 233B, FIG. 240 to FIG. 243C, FIG. 245, FIG. 247A, FIG. 265C, FIG. 352, FIG. 354, FIG. 356, FIG. 384, FIG. 386, FIG. 431A to FIG. 431C, FIG. 431E] formed during molding or casting of the membrane;
ionomers formed within a cross-linker bonding two polymer backbones together [FIG. 116, FIG. 118, FIG. 133C, FIG. 223, FIG. 226A, FIG. 226B, FIG. 301, FIG. 369, FIG. 375, FIG. 383, FIG. 396, FIG. 431L, FIG. 431Q] formed during molding or casting of the membrane or during subsequent cross linking steps;
ionomers formed on at least one chain of multiple copolymers chemically bound together [FIG. 121, FIG. 122, FIG. 133A, FIG. 135B, FIG. 139, FIG. 209A, FIG. 209B, FIG. 210, FIG. 211A to FIG. 211F, FIG. 224, FIG. 235A, FIG. 235B, FIG. 237, FIG. 375, FIG. 387 to FIG. 392, FIG. 394, FIG. 397, FIG. 398, FIG. 399B, FIG. 401A to FIG. 401D, FIG. 427A, FIG. 429B, FIG. 429D, FIG. 429G, FIG. 431F, FIG. 431O, FIG. 431P] formed during molding or casting of the membrane or during subsequent cross linking steps;
ionomers formed on at least one chain of multiple heteropolymers not chemically bound together but structurally entangled [FIG. 125, FIG. 227, FIG. 303, FIG. 304, FIG. 376, FIG. 429A, FIG. 429B, FIG. 429D, FIG. 429G] formed during molding or casting of the membrane or during subsequent annealing;
ionomers attached via short sidechains structurally entangled to vacancies within a polymeric matrix via nanoparticle sprays or nanocoatings [FIG. 104, FIG. 106, FIG. 156, FIG. 201, FIG. 293, FIG. 295, FIG. 305B, FIG. 305C, FIG. 306A, FIG. 306B, FIG. 342, FIG. 343, FIG. 344];
ionomers grafted onto polymer backbones via graft points formed by radiation or chemical reagents [FIG. 105, FIG. 114, FIG. 225, FIG. 302, FIG. 431Q] formed during molding or casting of the membrane or during subsequent annealing;
ionomers attached to a grid-like polymeric or co-polymer matrix [FIG. 142, FIG. 145, FIG. 146, FIG. 147, FIG. 148, FIG. 151, FIG. 152, FIG. 156, FIG. 185B, FIG. 240 to FIG. 243C, FIG. 244, FIG. 267 to FIG. 269, FIG. 309, FIG. 357, FIG. 358, FIG. 365, FIG. 374, FIG. 401A to FIG. 401D, FIG. 431A, FIG. 431I] formed during molding or casting of the membrane or during subsequent thermal or chemical processing steps;
ionomers attached to nanostructures bonded to a polymer or copolymer backbone [FIG. 156, FIG. 157, FIG. 185A, FIG. 185B, FIG. 190 to FIG. 194, FIG. 195, FIG. 199 to FIG. 204, FIG. 200, FIG. 244, FIG. 251 to FIG. 256B, FIG. 271 to FIG. 291, FIG. 294 to FIG. 300, FIG. 302 to FIG. 304, FIG. 305A to FIG. 305D, FIG. 306A to FIG. 306, FIG. 308 to FIG. 311, FIG. 313 to FIG. 333B, FIG. 335 to FIG. 339, FIG. 341 to FIG. 349, FIG. 358 to FIG. 361, FIG. 372, FIG. 373, FIG. 377, FIG. 378, FIG. 393 to FIG. 396, FIG. 398, FIG. 400, FIG. 401C, FIG. 401D, FIG. 427B] formed during molding or casting of the membrane or during subsequent annealing; and
ionomers attached to one or more segments of block copolymers [FIG. 427A to FIG. 427C, FIG. 428A to FIG. 428L] formed during molding or casting of the membrane or during subsequent annealing.

Some embodiments of the above described structures contain multiple ionomeric features combined to form exemplary inventive ion exchange membranes. Ion exchange membranes made in accordance with this invention include [FIG. 430] either homo-ionomer or hetero-ionomer films combining (i) endoskeletal support enhancing membrane strength, durability, and reliability while reducing the adverse impact of hydration variations on electrical performance; (ii) micropores fabricated using sacrificial fillers beneficially affecting membrane porosity and conductivity; (iii) permanent membrane fillers controlling crystallinity, reducing fuel crossover, and improving ion transport efficiency; (iv) ionic liquids and dopants, and/or (v) nanoparticle coatings enhancing catalysis, inhibiting IL or acid fluid leakage from the IEM, along with mitigating gaseous environmental toxins from damaging ionomers and catalysts. In addition to the foregoing, the membrane may be combined with heterogenous and bifurcated multifunctional catalyst layers (CLs) and/or with heterogenous stepped or graded gas diffusion layers (GDLs).

These unique structural, material, and electrical features made in accordance with this invention can be used in various combinations with the polymers described herein, the processes of which are not only non-obvious but incompatible without accompanying chemical techniques to enable membrane synthesis. For example, absent the processing methods articulated herein, most hydrophilic ionomers are structurally incompatible with inert hydrophobic polymer backbones such as polytetrafluoroethylene (PTFE) and are unable to form stable reliable ion exchange membranes. In simple terms because polar and non-polar molecules are incompatible unless extraordinary and non-obvious processing methods are undertaken, hydrophobicity required to form and maintain structural integrity of a membrane is directly counter to the hydrophilicity need to transport charge to-and-from immobile ionomeric groups attached to the polymeric backbone. Improving conductivity by enhancing the PFSA content invariably is countered by reduced mechanical strength susceptible to swelling and drying causing film expansion, contraction, cracking, and leakage.

Attempts to overcome the fundamental incongruity betwixt hydrophobic and hydrophilic behavior in commercial films such as Nafion®, Aquivion®, Gore Select®, and others face a fundamental tradeoff in film conductivity, substituting electrically active PFSA domains with inert PTFE (Teflon®) regions interspersed throughout the film, a hybrid molecular structure referred to as a composite reinforced membrane or CRM. Invariably in a fluorocarbon CRM IEM, the higher the PTFE content, the stronger yet less conductive the membrane becomes.

In various embodiments of this invention, polymer and skeletal incompatibilities are overcome by the prudent application of cross linkers, molecular glues, coatings, and compatible skeletal pillar chemistries. Although the various inventive fabrication methods and membrane designs described herein can ostensibly be used in nearly any combination, permutation, and configuration of polymer, ionomer (acid), skeleton, and filler, not every option is able to produce functional or stable ionomeric films. The specific details of compatible combinations, described herein on a cases-by-case basis, can however be generalized by categories of polymers [FIG. 430] used to form the ionomeric conductive film.

One broad categorization used in the selection of beneficial IEM moieties synthesized in accordance with this invention is based on the significant distinction between fluorocarbon (FC) membranes and hydrocarbon membranes. In one set of embodiments of this invention, homopolymer fluorocarbon membranes described herein include the homopolymer of bulk polyfluorinated sulfonic acid (PFSA) and various di-monomer based fluorocarbon compounds such as the composite reinforced membrane (CRM) of polyfluorinated sulfonic acid and polytetrafluoroethylene (PFSA-PTFE) [FIG. 107, FIG. 431D]; the fluorinated glassy matrices of poly(perfluoro-methylene-methyl-dioxolane) (PFMMD) [FIG. 108, FIG. 110, FIG. 431D] and perfluoro-(dimethyl-dioxole) (PDD) [FIG. 109, FIG. 110, FIG. 431D]; and perfluoro-imide acid (PFIA) [FIG. 264, FIG. 266, FIG. 431D] and other multi-acid sidechains [FIG. 285C] such as ortho-bis acid.

In order to improve the electrical performance of PFSA over commercial films, methods demonstrated in this application, include a coating process treating a PTFE membrane with polyvinyl alcohol (PVA) then soaking the film in a solution of PFSA and PTFE nanoparticles [FIG. 77A] to form a PFSA-PTFE composite reinforced membrane (CRM). In one embodiment, in order to compensate for conductance lost by a preponderance of inert components of CRMs the application of the conductive PFSA nanoparticles is accompanied by substantially thinning the membrane resulting in measured electrical characteristics having less voltage sag at higher current densities [FIG. 79A] and higher output power [FIG. 79B]. The coated membrane process [FIG. 77B] may be combined with an endoskeletal support and the sacrificial micropore formation processes to further enhance mechanical stability, enhance conductance and reducing swelling and water logging.

In various embodiments of micropore the formation process [FIG. 81] made in accordance with this invention the sacrificial filler may be blended with the film's monomers as powder, concurrently dissolved and blended together in solution, or dissolved and blended in succession, then followed by polymerization, and finally by dissolving and removing the sacrificial filler before dehydration baking. Measured results confirm the porous PEM exhibits significantly reduced voltage sag and higher current densities [FIG. 85A], higher output power and high conversion efficiencies [FIG. 85D, FIG. 86] and reduced power losses [FIG. 85E, FIG. 85 F] compared to commercial PEM films or nanocoated CRM membranes

Compared to hydrocarbons, the fluorocarbon bond F—C offers high thermal stability in moderately elevated temperatures, and high resilience to chemical degradation. Fluorocarbons also provides excellent mechanical strength and durability, especially when reinforced as in PFSA-PTFE CRMs or using skeletal support made in accordance with this invention. Mechanical and chemical resilience renders fluorocarbon compounds suitable for long-term use in demanding environments. Moreover, the high density of sulfonic acid groups in fluorocarbon membranes provides high proton conductivity and efficient fuel cell operation. Inherent disadvantages of fluorocarbons include higher manufacturing cost and process complexity, inability to operate at extremely high temperatures, mechanical rigidity leading to handling induced breakage, and environmental impact concerns regarding forever chemicals. Although these challenges are mitigated by the methods and designs described herein, they are not entirely eliminated.

In other embodiments of this invention, hydrocarbon (H—C) or only slightly fluorinated compounds are used to form a variety of ionomeric polymer moieties. Hydrocarbon membranes offer good chemical stability in acidic and basic environments, making them suitable for various electrochemical applications, but do not offer the structural stability or chemical resilience of polymers based on the FC bond. This difference in structural integrity can primarily be explained by bond strength and valance states. Specifically, the F—C and F—O bonds present in fluorocarbon membranes exhibit exceptionally strong bonding energies of 5 eV (485 kJ/mol) and 5.8 eV (565 kJ/mol) respectively. By contrast, the binding energies of the H—C bonds in hydrocarbons are only 4.3 eV (411 kJ/mol), even 10% lower than that of weak H—H bonding.

One benefit of lower bonding energies is that hydrocarbons do not constitute forever chemical like PFAS compounds do, and are therefore more biocompatible. They are also lower cost to produce. The lower mechanical strength and reduced conductivities of hydrocarbon plastic compounds, however, increases their reliance on several of the inventive embodiments described herein specifically skeletal support, sacrificial filler controlled porosity, permanent filler controlled porosity and charge transport, and ionic liquid enhanced conductivity. Only through the prudent application of inventive structural modifications and processing steps described herein can hydrocarbon IEMs compete with fluorocarbon membrane performance and resilience.

Although there is no simple measure to correlate dissimilarly constructed hydrocarbon polymers to one another nor has any published studies to date discussed the topic, detailed analysis provided herein reveals a general trend of a monotonic progression in a polymer's electrical and mechanical characteristics based on the length and complexity on the polymeric backbone forming the structure, especially when comparing polymers sharing the same ionomeric acid groups.

When arranged in progression from simple short monomers to long complex co-polymers, a general trend in material properties emerges. Accordingly, the polymers used in ionomeric membranes made in accordance with this invention [FIG. 430] are summarily arranged here by polymer length and complexity. From simple-and-short to long-and-complex these hydrocarbon based polymer groups include (i) homopolymers, (ii) di-monomers, (iii) hybrid heteropolymers, (iv) copolymers, and (v) block copolymers. Aside from these fluorocarbon and hydrocarbon ionomers, special categories of ionomeric polymers include anhydrous polymers good for high temperature operation not involving water-charge transport, and biopolymers offering superior biocompatibility using readily available natural polymers.

Despite the broad spectrum of polymers covered in varying embodiments of this invention, some general observations can be made in pairing the requisite inventive embodiments to specific membrane chemistries. While these trends are not intended to be limiting, they are insightful in selecting the best combinations of polymer and membrane construction able to overcome inherent deficiencies in conventionally fabricated ion exchange membranes.

Specifically, simple HC polymers comprised of short homopolymers offer lower cost and higher mechanical strength due to their uniform tightly packed atomic structures, but operate over narrower temperature ranges, exhibit lower conductivities, and suffer from excessive fuel cross over effects. The shortcomings of simple HC polymer based membranes can be ameliorated using processes and methods described herein.

The intermediate HC polymer category referred to here as di-monomers, comprises a quasi-uniform polymeric spine of hydrocarbon formed from the mixing and polymerization of two monomers into a single spine. Like short simple HC monomers, these polymers also exhibit lower conductivities than more complex ionomeric polymers but offer superior control over porosity compared to homopolymers. Nonetheless, numerous embodiments of this invention are able to improve the electrical and material properties of di-monomer membranes.

A third category, hybrid HC heteropolymers or ‘multi-polymers’ combine alternating sequences of polymer segments of differing monomer combinations, varying the pattern and length of the alternating segments in defined sequences and repetitions. Beneficially the partitioning a polymer spine into heterogenic segments affords the ability to balance hydrophobic and hydrophilic components, specifically where the hydrophobicity of inert segments controls polymer strength and film durability, and where hydrophilic groups containing acids and ionomers control charge transport. Unlike longer copolymer constructions, hybrid heteropolymers contain a limited number of monomer types and functional groups such as arylene, ether, ketones, sulfones, and nitrile, all able to bond together in a linear carbon spine without the need for cross linkers.

Hybrid heteropolymers deliver enhanced conductivity and controlled porosity with superior fuel crossover management but at the expense of reduced mechanical strength, lower film integrity, higher moisture retention, greater swelling, and poorer temperature cycling and humidity cycling performance. In general, hybrid heteropolymers form better conductors than shorter homopolymers and di-polymers but suffer from poorer mechanical and material properties such as durability, chemical resilience, and temperature coefficient of expansion. They are however mechanically stronger but less conductive than copolymers.

That said, numerous embodiments of this invention are able to improve the electrical and material properties of hybrid heteropolymer membranes. Depending on the polymer's sequencing, the application of beneficial features can be adapted to address the specific deficiencies of a heteropolymer. For example heteropolymers that utilize a higher proportion of hydrophobic segments benefit more rom the enhanced conductivity of ionomeric permanent fillers, hetero-ionomers, and ionic liquid doping; while those with higher ionomeric densities suffering from reduced porosity of a denser quasi-crystalline membrane better benefit from microporous films formed using the inventive sacrificial filler process defined herein.

Copolymers comprise complex polymeric backbones of multiple dissimilar polymer segments bonded by a third molecular component called a cross linker (XL). Unlike hybrid heteropolymers which comprise mutually compatible polymeric segments able to bond directly to one another, copolymers require these cross linkers to form an integrated molecular structure or matrix. The polymeric chains may be either short or long depending on the specific polymer's stoichiometry.

A cross linker is a molecule that includes two different functional groups generally as the termini on the linker molecule. The linking molecule may comprise a short chain, a cyclic ring, or a larger molecule with two functional groups sufficiently spaced apart so as to not interfere with one another, e.g. diametrically opposed termini on a linear chain or functional groups R and R′ attached on opposite sides of a cyclic ring, i.e. in the 1,4 or 2,5 positions of a benzene ring. A key feature of a cross linker is the difference between its two functional groups, where one group has an affinity to one polymer's construction and another group which preferentially bonds to a second polymer. For example one XL termini may be polar and the other termini non-polar, thereby enabling cross linking between two polymers. For example, a cross linker may attach to polar groups on polymer-A and non-polar groups on polymer-B. By cross-linking even mutually incompatible polymers can form copolymers. The bonding may form extended rectilinear chains, linked quasi-parallel chains, orthogonally bonded chains, or a matrix of monomers forming grid-like patterns.

Like hybrid heteropolymers, copolymers offer superior conductivity with limited fuel crossover tailored to operate over wider or well-defined temperature ranges. These more complex polymers, however also suffer from weaker mechanical strength, poorer film durability, and higher manufacturing costs. Because the length of the constituent polymers are longer the benefit of a copolymer is its ability to average the properties of its constituents, deriving its strength from one polymer while concurrently facilitating conduction through a second polymer. Depending on the copolymer's blend, the application of beneficial features of this invention can also be adapted to address the specific deficiencies of copolymers.

Because of its ability to integrate structural diverse polymers, embodiments made in accordance with this invention can be applied to copolymers in unique combinations. For example by attaching ionomer A to polymer A and ionomer B to polymer B, then in one embodiment of this invention a copolymer of ionomer A and ionomer B provides a direct means to synthesize a hetero-ionomer. In one embodiment of this invention, a perfluorosulfonic acid—polytetrafluoroethylene (PFSA-PTFE) polymer with a sulfonic acid group is cross linked to a hydrocarbon polymer containing a phosphonic acid group such as polybenzimidazole (PBI) or alternatively to poly(arylene ether sulfone) (PAES); polyphosphate (Pz); or polyvinylidene fluoride (PVDF). The resulting copolymer PFSA-PTFE-co-PBI contains a sulfonic acid (HSO₃)—phosphonic acid (H₃PO₃) hetero-ionomer [FIG. 432C] able to deliver superior conductivity over a wide range of temperatures, humidity levels, and pH values.

In other embodiments, sacrificial pores formed using the described sacrificial filler process or a matrix of endoskeletal support can be applied to copolymers without concern to the chemical composition of copolymer or its ionomers. The beneficial properties of the skeleton and sac pores is their independence, properties achieved because both elements are agnostic to the membrane polymer chemistry so long that at least one of the polymers bond to the skeleton either being intrinsically compatible with the composition of the skeletal pillar or because bonding is facilitated by a cross linking agent or molecular glue.

Block copolymers represent yet another molecular class comprising designer polymers formed by sequential or statistical assembly methods. Like heteropolymers and copolymers the application of the inventive features described herein can be adapted to compensate for intrinsic deficiencies in a block polymer's mechanical, structural, chemical, or electrical characteristics.

Embodiments of hydrocarbon homopolymers described herein include polyphenylene [FIG. 153, FIG. 431A]; phenyl-alkane [FIG. 219, FIG. 220, FIG. 222], phenyl-aldehyde [FIG. 221, FIG. 222, FIG. 431A], covalent triazine [FIG. 246, FIG. 240, FIG. 243A, FIG. 246]; polyvinyl alcohol [FIG. 114, FIG. 117, FIG. 431A]; polystyrene [FIG. 136, FIG. 431B]; polysulfone [FIG. 229, FIG. 231, FIG. 338, FIG. 360, FIG. 362, FIG. 431B]; polyimide [FIG. 129, FIG. 130, FIG. 132, FIG. 293, FIG. 285A, FIG. 431G]; benzene-phenylene [FIG. 139, FIG. 140, FIG. 153, FIG. 431B, FIG. 431E]; poly(trifluorostyrene) [FIG. 223, FIG. 431B]; poly(ether imide) [FIG. 180, FIG. 431C]; cross-linked poly vinyl alcohol (XL PVA) [FIG. 431L]; cross-linked (XL) polystyrene [FIG. 134, FIG. 135B, FIG. 136, FIG. 388, FIG. 431F]; and cross-linked sulfonated poly(trifluorostyrene) (sPTFS-x-(sPTFS-co-PTFS)) [FIG. 431Q].

In pristine form, hydrocarbon homopolymers as articulated here offer lower manufacturing costs and higher mechanical strength than longer spine polymers but suffer from narrower temperature operating range, lower porosity and reduced conductivities, especially operating below 100° C. In one set of embodiments, a hydrocarbon homopolymer ion exchange membrane includes sacrificial pores to enhance porosity, and includes permanent fillers to control crystallinity, enhance conductivity, and improve charge transport efficiency.

In this context, the term ‘set of embodiments’ refers to the application of the described method to each particular polymer stoichiometry. In another set of embodiments, a skeletal matrix is included to reduce the influence of temperature on the molecular matrix including the temperature coefficient of expansion (TCE) of the polymer. The selection of the endoskeletal pillar material and/or pillar linking adhesive such as a cross linker or molecular glue is polymer specific, the details of which are described herein in their respective sections.

In yet another set of embodiments, the polymer contains a hetero-ionomer of two different membrane attached acids forming immobile anion groups in a proton exchange membrane or immobile cations in a anion exchange membrane. The inventive co-ionomer feature as described enhances conductivity and widens the useful temperature range of ionomeric conduction. In another set of embodiments the film is treated with an ionic liquid to enhance membrane conductivity, and where a skeletal membrane and optional nanocoating is included to prevent leakage of the ionic liquid into its surroundings.

Embodiments of hydrocarbon di-monomers include maleic anhydride poly(methyl methacrylate) (MAH-PMMA) [FIG. 259, FIG. 261, FIG. 262, FIG. 431E]; polyethylene [FIG. 112, FIG. 113, FIG. 431E]; polyvinyl chloride [FIG. 127, FIG. 128, FIG. 431E]; phenylsulfonyl poly(benzoyl-phenylene) [FIG. 175A, FIG. 214, FIG. 431E]; poly phosphazene [FIG. 235A, FIG. 235B, FIG. 236, FIG. 420, FIG. 431F]; poly siloxane [FIG. 237, FIG. 238, FIG. 431F]; and triazine bisphenol [FIG. 245, FIG. 431A]. As articulated here, hydrocarbon di-monomers, like HC homopolymers, offer lower manufacturing costs and higher mechanical strength than longer spine polymers but suffer from narrower temperature operating range, lower porosity and reduced conductivities.

In one set of embodiments, a hydrocarbon di-monomer ion exchange membrane includes sacrificial pores to enhance porosity, and includes permanent fillers to control crystallinity, enhance conductivity, and improve charge transport efficiency. In yet another set of embodiments, the polymer contains a hetero-ionomer of two different membrane attached acids forming immobile anion groups in a proton exchange membrane or immobile cations in a anion exchange membrane. The inventive co-ionomer feature as described enhances conductivity and widens the useful temperature range of ionomeric conduction. In another set of embodiments the film is molded with permanent fillers enhancing conductance and controlling porosity. In yet another embodiment an ionic liquid in introduced, post molding, into the membrane enhance membrane conductance. To prevent leakage, the IL is contained by a skeletal matrix molded into the membrane and sealed with a nanocoating of PTFE or other inert composition.

Embodiments of hydrocarbon hybrid heteropolymers also described herein as multi-polymers comprise without limitation poly fluorenyl ether ketone nitrile (PFEKN) [FIG. 137, FIG. 138]; poly(arylene ether sulfone) (PAESf, PAES) [FIG. 155, FIG. 159, FIG. 428E, FIG. 431H]; poly arylene ether—sulfonic acid (PAE-SA) matrix [FIG. 154, FIG. 431I]; poly(ether ketone) [FIG. 160 to FIG. 170, FIG. 431M]; poly(ether sulfone) [FIG. 171 to FIG. 180, FIG. 431M]; poly(ketone sulfone) [FIG. 181A, FIG. 181B, FIG. 431N]; poly(arylene ketone ether sulfone) [FIG. 182A to FIG. 184, FIG. 186]; poly(arylene ether sulfone-triazine bisphenol (P(SPAESf)-TzBPh) [FIG. 245, FIG. 431C]; and perfluoroalkoxy alkane graft polystyrene sulfonic acid (P(PFA)-g-PSSA) [FIG. 225, FIG. 431Q].

In one set of embodiments, sacrificial micropores are formed in the molecular matrix to control porosity and enhance conduction. In yet another set of embodiments, the polymer contains a hetero-ionomer of two different membrane attached acids forming immobile anion groups in a proton exchange membrane or immobile cations in a anion exchange membrane. The inventive co-ionomer feature as described enhances conductivity and widens the useful temperature range of ionomeric conduction. In another set of embodiments the film is molded with permanent fillers enhancing conductance and controlling porosity. In yet another embodiment an ionic liquid in introduced, post molding, into the membrane enhance membrane conductance. To prevent leakage, the IL is contained by a skeletal matrix molded into the membrane and sealed with a nanocoating of PTFE or other inert composition.

Embodiment made in according to this invention comprising hydrocarbon and fluorocarbon copolymers include without limitation thermoplastic polyurethane divinyl benzene (PTPU-co-sDVB) [FIG. 226A, FIG. 226B, FIG. 228, FIG. 431I]; perfluoro-methylene-methyl-dioxolane-co-perfluoro-methylene-dioxolane (P((PFMDD-SA)-co-PFMD)) [FIG. 207, FIG. 211A, FIG. 212, FIG. 431J]; perfluoro-methylene-methyl-dioxolane-co-chlorotrifluoro ethylene P((PFMDD-SA)-co-CTFE) [FIG. 207, FIG. 211C, FIG. 212, FIG. 431J]; perfluoro-methylene-methyl-dioxolane-sulfonic-acid-co-perfluorostyrene (P((PFMMD-SA)-co-PFSt)) [FIG. 211E, FIG. 211F, FIG. 212, FIG. 431J]; poly(dioxodihydropyrrole-co-carbonyl sulfonyl fluoride-co-styrene-sulfonic acid (PDDP-co-(CSFSt-SA)) [FIG. 215A, FIG. 215B, FIG. 216, FIG. 431J]; sulfonated polyphenylene quaterphenol (sPPh-co-QPh) [FIG. 141, FIG. 431K]; and sulfonated polyamide-co-sulfonimide (sSPA-co-Slm) [FIG. 233A, FIG. 233B, FIG. 234].

Other copolymer embodiments include polyvinylidene fluoride-x-sulfonated polyvinyl alcohol (PVDF-x-PVA-sPVA) [FIG. 119, FIG. 431L]; polyvinylidene fluoride-co-sulfonated polycarbonate (PVDF-co-sPC) [FIG. 119, FIG. 431L]; polyvinylidene fluoride-co-perfluorosulfonic acid (PVDF-co-PFSA) [FIG. 119, FIG. 124]; polyvinyl difluoride-co-polyvinyl pyrrolidone-co-polystyrene sulfonic acid (PVDF-co-PVP-co-PSSA) [FIG. 118, FIG. 124, FIG. 431O]; polyvinylidene fluoride-co-polyvinylidene pyrrolidone sulfonic acid (PVDF-co-PVP-SA) [FIG. 118 to FIG. 120, FIG. 124, FIG. 431O]; polyvinylidene fluoride-co-azobisiso butyronitrile 3-sulfopropyl acrylate (PVDF-co-AIBN-SPA) [FIG. 121, FIG. 124, FIG. 431P]; polyvinylidene fluoride-co-azobisiso butyronitrile 3-sulfopropyl acrylate-co-perfluoro hexene (PVDF-co-AIBN-SPA-co-F₆PP) [FIG. 122, FIG. 124, FIG. 431P]; and sulfonated polyvinylidene fluoride-co-hexafluoropropylene (PVDF-co-F₆PP) [FIG. 123, FIG. 124, FIG. 431P].

Although copolymer films offer high conductivity thereby reducing the need for sacrificial micropores or ionic liquids, their propensity for swelling and water logging can impede fuel cell operation and compromise the structural integrity of the membrane. In one embodiment, permanent fillers such as carbon nanotubes or graphene oxide are introduced into the membrane to stabilize the atomic structure against excessive expansion and contraction with hydration and varying temperature perturbations. In another embodiment, an inert skeletal structure is molded into the membrane to provide added mechanical support limiting deformation from hydration fluctuations during operation.

Similarly block copolymers provide a degree of programmability in film characteristics not possible in the aforementioned heteropolymers and copolymers. These include alternating di-block copolymers [FIG. 428D, FIG. 428K]; tri-block copolymers [FIG. 428AJ]; quad-block copolymers [FIG. 428B]; penta-block copolymers [FIG. 428A]; random multi-block copolymers [FIG. 428E]; branched multi-block copolymers [FIG. 428F, 428G]; mirror-block copolymers [FIG. 428C]; sidechain-block copolymers [FIG. 428I, FIG. 428L]; and comb-block copolymers [FIG. 428H].

Synthesis of block copolymers made in accordance with this invention include excision insertion reaction [FIG. 427A]; modified ring opening polymerization (MROP) [FIG. 427B]; nucleophilic aromatic substitution reaction [FIG. 427C]; atomic transfer radical polymerization (ATRP) [FIG. 427D]; and cross-linker polymerization (XLP) [FIG. 427E]. Various embodiments of block copolymers and their fabrication include skeletal support; sacrificial pores; permanent fillers; hetero-ionomers; ionic liquids; and nanocoatings, the combinations of which are matched to the specific block polymer according to its deficiencies.

Embodiments of anhydrous polymers made in accordance with this invention comprise various variants of phenylene bibenzimidazole (PBI) including oxydiphenylene-bibenzimidazole (OPBI) [FIG. 364, FIG. 365]; poly(arylene ether benzimidazole) (PAEBI) [FIG. 366]; poly-phenylene-bibenzimidazole (p-PBI, PBI) [FIG. 368A, FIG. 431R], poly(dihydroxy-phenylene bibenzimidazole) (20H-PBI) [FIG. 368A]; hexafluoroisopropylidene-polybenzimidazole (F₆—PBI) [FIG. 368A]; sulfur dioxide polybenzimidazole (SO₂—PBI) [FIG. 368B]; dioxy-polybenzimidazole (2O-PBI) [FIG. 368B].

Other bibenzimidazole moieties include cross-linked bibenzimidazole [FIG. 369], poly(phenylene-bibenzimidazole side-chain sulfone (SC-SO₂—PBI); and the copolymers imidazole chlorocyclotriphosphazene-co-polybenzimidazole (ImCCP-co-PBI) [FIG. 373]; oxydiphenylene—bibenzimidazole-co-polyvinyl-benzyl-chloride-co-diazabicyclo-octane-co-quinuclidine (OPBI-co-QN-PVBC-co-DABCO) [FIG. 375]; oxydiphenylene-bibenzimidazole-co-zeolitic imidazolate framework (PBI-co-ZIF) [FIG. 377]; and oxydiphenylene-bibenzimidazole-co-polyaniline-co-quaternary ammonia (OPBI-co-PANI-QA) [FIG. 376].

Embodiments of biopolymer membranes made in accordance with this invention include polydopamine [FIG. 310, FIG. 397, FIG. 398, FIG. 399A, FIG. 399B, FIG. 402, FIG. 431R]; chitosan [FIG. to FIG. 385C, FIG. 388, FIG. 390, FIG. 392, FIG. 394, FIG. 399B, FIG. 400, FIG. 401C, FIG. 401D, FIG. 402, FIG. 431R]; cellulose (CE) [FIG. 380]; and alginic acid (AA) [FIG. 380].

Various bio-copolymer embodiments of the invention comprise sulfonated chitosan (sCS) [FIG. 382]; R-functionalized chitosan-co-polystyrene ((CS-co-PS)—R) [FIG. 388]; R-functionalized chitosan-co-polyvinyl alcohol ((CS-g-PVA)-R) [FIG. 389]; chitosan-g-perfluorinated sulfonic acid (CS-co-PFSA) [FIG. 390]; chitosan-b-perfluorinated sulfonic acid (CS-b-PFSA) [FIG. 382]; cross linked sulfonated chitosan (XL-sCS) [FIG. 383]; chitosan-g-vinylpyridine (CS-g-PVP) [FIG. 392]; chitosan-g-styrenesulfonic acid (CS-g-SSA) [FIG. 394]; D-glucosamine-co-polydopamine (CS-co-PDA) [FIG. 399A]; D-glucosamine-co-polydopamine-R (CS-co-fPDA) [FIG. 399B]; polyoctahedral silsesquioxanes doped cross-linked chitosan (POSS XL-CS) [FIG. 396]; and chitosan-g-styrenesulfonic acid carbon nanotubes (CS-g-SSA-CNT) [FIG. 395].

### Ionomeric Acids.

Embodiments of ionomeric polymeric membranes made in accordance with this invention comprise various different acid-based ionomers [FIG. 432A, FIG. 432B]. These include the sulfur ionomers of sulfuric acid (H₂SO₄), sulfonic acids (HSO₃), sulfamic acids (H₃NSO₃), and sulfosuccinic acid (SSA); the phosphorus ionomers of phosphonic acid (H₃PO₃), ionized phosphoric acid [H₂PO₄]⁻, and phosphotungstic acid (PWA); and other organic compounds namely phenol hydroxide (PhOH), carboxylic acid (R—COOH), and the amide group (R—CONH). Other embodiments include the ionomeric groups ethyl lactate (C₅H₁₀O₃); diethylphosphate (DEP); citric acid (C₆H₈O₇); glycolic acid (C₂H₄O₃); butyric acid (C₃H₇COOH); pyruvic acid (C₂H₄O₃); acetic acid (AA); and trifluoromethanesuIphonic acid (triflate). In accordance with this invention, the homo-ionomers can be combined with any compatible polymers described previously.

In another set of embodiments, ion exchange membranes with enhanced performance comprise hetero-ionomers able to operate over a wider range of power, temperature, and hydration conditions. Exemplary inventive hetero-ionomeric membranes [FIG. 432C] include the sulfuric-acid—sulfamic acid pair (H₂SO₄·H₃NSO₃); the sulfonic acid—phosphonic acid pair (H₃SO₃·H₃PO₃); the sulfonic acid—phenol hydroxide pair (HSO₃·PhOH); and the sulfosuccinic acid—sulfonic acid pair (SSA·HSO₃). Other inventive co-ionomer combinations [FIG. 432D] include the pyruvic acid—butyric acid pair (C₂H₄O₃·C₃H₇COOH); the diethylphosphate—triflate pair (DEP·TF); and the citric acid—ascetic acid pair (C₆H₈O₇·AA).

In one embodiment, sulfuric acid (H₂SO₄) formed within the ion exchange membrane is converted into an immobile divalent anionic ionomer comprising sulfate (SO₄)²⁻, or into an immobile monovalent anionic ionomer comprising hydrogen sulfate (HSO₄)⁻, or a combination of both. The ionomers may attach to one of several compatible polymeric backbones including perfluorosulfonic acid (PFSA) polymer such as Nafion; polybenzimidazole (PBI); sulfonated poly(ether-ether ketone) (SPEEK); sulfonated poly(phenylene oxide) (SPPO); sulfonated polyimides (SPI); sulfonated poly(arylene ether sulfone) (SPAES); and poly(vinylidene fluoride) (PVDF) blended with sulfonated polymers; and others.

In another embodiment, sulfonic acid (HSO₃) formed within the ion exchange membrane is converted into the immobile monovalent anionic ionomer sulfonate (SO₃)⁻. The ionomer may attach to one of several compatible polymeric backbones including perfluorosulfonic acid (PFSA) polymer such as Nafion; sulfonated poly(ether-ether ketone) (SPEEK); sulfonated poly(phenylene oxide) (SPPO); sulfonated polyimides (SPI); sulfonated poly(arylene ether sulfone) (SPAES); poly(styrene sulfonic acid) (PSSA); poly(vinylidene fluoride) (PVDF) blended with sulfonated polymers; and others.

In another embodiment, sulfamic acid (H₃NSO₃) formed within the ion exchange membrane is converted into the immobile monovalent anionic ionomer sulfamate (H₂NSO₃)⁻. The ionomer may attach to one of several compatible polymeric backbones including perfluorosulfonic acid (PFSA) polymer such as Nafion; sulfonated poly(ether-ether ketone) (SPEEK); sulfonated poly(phenylene oxide) (SPPO); sulfonated polyimides (SPI); sulfonated poly(arylene ether sulfone) (SPAES); sulfonated poly(arylene ether ketone) (SPAEK); poly(vinylidene fluoride) (PVDF) blended with sulfonated polymers; and others.

In another embodiment, sulfosuccinic acid (C₄H₆O₇S) or SSA formed within the ion exchange membrane is converted into the immobile monovalent anionic ionomer sulfosuccinate (C₄H₅O₇S)⁻ or (SSA)⁻. The ionomer may attach to one of several compatible polymeric backbones including perfluorosulfonic acid (PFSA) polymer such as Nafion; sulfonated poly(ether-ether ketone) (SPEEK); sulfonated poly(phenylene oxide) (SPPO); sulfonated polyimides (SPI); sulfonated poly(arylene ether sulfone) (SPAES); sulfonated poly(arylene ether ketone) (SPAEK); poly(vinylidene fluoride) (PVDF) blended with sulfonated polymers; and others.

In another embodiment, phenol hydroxide (C₆H₅R) or in its specific form phenol hydroxide (C₆H₅OH) or (PhOH) formed within the ion exchange membrane is converted into the immobile monovalent anionic ionomer phenoxide or phenolate, chemically as (C₆H₅O)⁻ or (PhO)⁻. The ionomer may attach to one of several compatible polymeric backbones including polybenzimidazole (PBI); functionalized poly(vinyl alcohol) (PVA) with crosslinking agents; functionalized poly(phenylene oxide) (PPO); functionalized poly(ether-ether ketone) (PEEK); functionalized poly(ethylene oxide) (PEO); functionalized polyimides (PI); functionalized polysulfone (PSU); and others.

In another embodiment, phosphonic acid (H₃PO₃) formed within the ion exchange membrane is converted into the immobile monovalent anionic ionomer dihydrogenphosphite (H₂PO₃)⁻. The ionomer may attach to one of several compatible polymeric backbones including perfluorosulfonic acid (PFSA) polymer such as Nafion; polybenzimidazole (PBI); poly(vinyl alcohol) (PVA) with phosphonic acid groups; poly(ether-ether ketone) (PEEK) with phosphonic acid groups; poly(ethylene oxide) (PEO) with phosphonic acid groups; polyimides with phosphonic acid groups; polysulfone (PSU) with phosphonic acid groups; and others.

In another embodiment, phosphoric acid (H₃PO₄) formed within the ion exchange membrane is converted into the immobile monovalent anionic ionomer dihydrogen phosphate (H₂PO₄)⁻, into the immobile divalent anionic ionomer hydrogen phosphate (HPO₄)⁻², or into the immobile trivalent anionic ionomer phosphate (PO₄)⁻³. Given their respective pKₐ values of 2.15, 7.2, and 12.4 for the single, double, and triple ionized variants, the monovalent species of dihydrogen phosphate is statistically more prevalent than hydrogen phosphate and phosphate, but not exclusively the only moiety present in the matrix. The ionomer may attach to one of several compatible polymeric backbones including polybenzimidazole (PBI); poly(vinyl alcohol) (PVA) with phosphoric acid groups; poly(ether-ether ketone) (PEEK) with phosphoric acid groups; poly(ethylene oxide) (PEO) with phosphoric acid groups polyimides with phosphoric acid groups; polysulfone (PSU) with phosphoric acid groups; and others without limitation, including polytetrafluoro-ethylene (PTFE).

In another embodiment, amide conjugate acid (R—CONH)⁻ is formed within the ion exchange membrane. As amides are derived from carboxylic acids, i.e. acids containing a (—COOH) where the molecule's OH terminus is substituted with an NH₂ group, the resulting structure (R—CONH₂) immediately deprotonates to form the amide conjugate acid (R—CONH)⁻ where the radical R bonds to a molecule such as CH₃ to form ethanamide (CH₃CONH₂) or the (CH₃CONH)⁻ anion. In the disclosed ionomeric however, the ionomer bonds to the polymeric backbone rather than affixing itself to a free radical R. Homo-ionomeric ion exchange membranes compatible with amide conjugate acids and immobile derivatives made in accordance with the following polymers: polybenzimidazole (PBI); polyamide-imide (PAI), polyimides; poly(ether-ether ketone) (PEEK); poly(vinyl alcohol) (PVA) poly(ethylene oxide) (PEO); and others.

In another embodiment, carboxylic acid (R—COOH) formed within the ion exchange membrane is converted into the immobile monovalent anionic ionomer carboxylate (R-COO)-. The ionomer may attach to one of several compatible polymeric backbones including polybenzimidazole (PBI); poly(vinyl alcohol) (PVA) with carboxylic acid groups; poly(ether-ether ketone) (PEEK) with carboxylic acid groups; poly(ethylene oxide) (PEO) with carboxylic acid groups; polyimides with carboxylic acid groups; polysulfone (PSU) with carboxylic acid groups; and others.

In another embodiment, phosphotungstic acid (PWA) formed within the ion exchange membrane is converted into the immobile monovalent anionic ionomer (PWA)⁻ referred to as phosphotungstate anion. The ionomer may attach to one of several compatible polymeric backbones including polybenzimidazole (PBI); poly(vinyl alcohol) (PVA) with phosphotungstic acid groups; poly(ether-ether ketone) (PEEK) with phosphotungstic acid groups; poly(ethylene oxide) (PEO) with phosphotungstic acid groups; polyimides with phosphotungstic acid groups; polysulfone (PSU) with phosphotungstic acid groups; and others.

Other embodiments of hydrocarbons and acids [FIG. 432B] suitable for forming anionic ionomers include ethyl lactate (C₅H₁₀O₃) converted into monovalent anionic ionomer (C₅H₉O₃)⁻; citric acid (C₆H₈O₇), pKₐ=+3.1, converted into monovalent anionic ionomer (C₆H₇O₇)⁻ 6311; glycolic acid (C₂H₄O₃), pKa=+3.83, converted into monovalent anionic ionomer (C₂H₃O₃)⁻ 6312; diethylphosphate (DEP), pKₐ=+1.5, converted into monovalent anionic ionomer (DEP)⁻ 6313; butyric acid (C₃H₇COOH), pKₐ=+4.82, converted into monovalent anionic ionomer (C₃H₇COO)⁻ 6314; pyruvic acid (C₃H₄O₃), pKₐ=+2.49 converted into monovalent anionic ionomer (C₃H₃O₃)⁻; acetic acid (AA), pKₐ=+4.76 converted into monovalent anionic ionomer (AA)⁻ 6316; and trifluoromethane sulphonic acid or triflate (TF), pKₐ=−14 converted into monovalent anionic ionomer (TF)⁻ 6317.

In one set of embodiments the listed ionomers are combined with specific polymers chosen for chemical compatibility and structural integrity. In one set of embodiments because of its inert reactivity and chemical stability perfluorosulfonic acid (PFSA) polymer such as Nafion® is combined with various ionomers including ethyl lactate, citric acid, glycolic acid, diethylphosphate, butyric acid, pyruvic acid, acetic acid, and triflate. Given its superior thermal stability in another set of embodiments, polybenzimidazole (PBI) is combined with citric acid, glycolic acid, pyruvic acid, and acetic acid. Having good chemical resistance and excellent proton conductivity, in another set of embodiments sulfonated polyether ether ketone (SPEEK) with is combined with vitric acid, glycolic acid, pyruvic acid, acetic acid, and triflate.

With superior mechanical properties and resilience to chemical attack, in another set of embodiments, polyvinylidene fluoride (PVDF) and polyetherimide (PEI) are combined with ethyl lactate, citric acid, glycolic acid, pyruvic acid, and acetic acid. In another set of embodiments involving cost sensitive applications, polypropylene (PP) and polyethylene (PE) are combined with ethyl lactate, citric acid, glycolic acid, butyric acid, pyruvic acid, and acetic acid. In other embodiments polymers such as polyvinyl alcohol (PVA), poly(ether-ether ketone) (PEEK), and polysulfone (PSU) are combined with citric acid, glycolic acid, pyruvic acid, and acetic acid to form ion exchange membranes.

In a variety of embodiments made in accordance with this invention, the aforementioned polymers may by used in any combination with other inventive features of this application including endoskeletal support, micropores fabricated via sacrificial fillers, permanent fillers, membrane dopants including ionic liquids, and membrane coatings including catalysts, scavengers, MOFs, and barriers against gaseous toxins such as carbon monoxide.

### Hetero-Ionomer Acids.

In another class of embodiments made in accordance with invention, ionomeric membranes combining two dissimilar polymer-bound acids [FIG. 432C] are synthesized. One hetero-ionomer IEM variant includes the sulfuric-sulfamic-acid combination ((H₂SO₄)·(H₃NSO₃)) resulting in a membrane containing the co-ionomeric anions (HSO₄)⁻ and (H₂NSO₃)⁻ compatible with a variety of membrane polymers including perfluorosulfonic-acid-polytetrafluoroethylene copolymer (PFSA-PTFE); sulfonated polyether ether ketone (SPEEK); polybenzimidazole (PBI); polyvinylidene fluoride (PVDF); and the homopolymer polytetrafluoroethylene (PTFE) and others.

Another embodiment of a hetero-ionomer IEM variant includes the sulfonic-phosphonic-acid combination ((HSO₃)·(H₃PO₃)) resulting in a membrane containing the co-ionomeric anions (SO₃)⁻ and (H₂PO₃)⁻ compatible with a variety of polymers including perfluorosulfonic acid—polytetrafluoroethylene copolymer (PFSA-PTFE); poly(arylene ether sulfone) (PAES); polybenzimidazole (PBI); polyphosphazenes (Pz); and polyvinylidene fluoride (PVDF), and others.

Yet another embodiment of a hetero-ionomer IEM variant includes the sulfonic-acid phenol-hydroxide combination ((HSO₃)·(PhOH)) resulting in a membrane containing the co-ionomeric anions (SO₃)⁻ and (PhO)⁻ compatible with a variety of polymers including polysulfone (PSU); polyether ether ketone (PEEK); polybenzimidazole (PBI); poly(arylene ether sulfone) (PAES); and polyvinylidene fluoride (PVDF), and others.

Another embodiment of a hetero-ionomer IEM variant includes the sulfosuccinic-sulfonic-acid combination ((SSA)·(HSO₃)) resulting in a membrane containing the co-ionomeric anions (SSA)-chemically as (C₄H₅O₇S)⁻ along with (SO₃)⁻ compatible with a variety of polymers including poly(arylene ether sulfone) (PAES); polybenzimidazole (PBI); polyvinylidene fluoride (PVDF); polysulfone (PSU); polyether ether ketone (PEEK); and polystyrene sulfonate (PSS), and others.

Another embodiment of a hetero-ionomer IEM variant made in accordance with this invention [FIG. 432D] includes the pyruvic-butyric-acid combination ((C₂H₄O₃)·(C₃H₇COOH)) forming two immobile anionic ionomers, the pyruvate anion (C₂H₃O₃)⁻ 6315, and butyrate anion (C₄H₇O₂)⁻, mutually compatible with a variety of polymers including polyethylene (PE); polypropylene (PP); poly(ethylene-co-methacrylic acid) (PEMAA); poly(vinyl alcohol) (PVA); and poly(acrylic acid) (PAA), and others.

In another embodiment, a hetero-ionomer IEM variant made in accordance with this invention includes DEP-triflate combination (DEP·OTf), i.e. diethylphosphate (C₄H₁₀O₄P) and trifluoromethanesulphonic acid (—OTf, CF₃SO₃H) forming two immobile anionic ionomers—the diethylphosphate anion (C₄H₉O₄P)⁻ and triflate anion (CF₃SO₃)⁻, mutually compatible with a variety of polymers including polyethylene oxide (PEO); poly(methyl methacrylate) (PMMA); polyvinylidene fluoride (PVDF); poly(ethylene-co-vinyl acetate) (EVA); and poly(acrylonitrile) (PAN).

Another hetero-ionomer IEM variant includes the citric-acetic acid combination (CA·AA) where citric acid comprises (C₆H₈O₇) and where acetic acid comprises (CH₃COOH), forming two immobile anionic ionomers—the citrate anion (C₆H₅O₇)⁻³, and the acetate anion (C₂H₃O₂)⁻ compatible with a variety of polymers including poly(vinyl alcohol) (PVA); poly(ethylene glycol) (PEG); poly(acrylic acid) (PAA); poly(ethylene-co-methacrylic acid) (PEMAA); and poly(vinyl acetate) (PVAc).

In the aforementioned exemplary embodiments, combining two different ionomers into the same film expands the operating range of an ion exchange membrane beyond that of single ionomer electrochemistry. Benefits include higher conductivity, wider humidity operating range, wider temperature operating and storage range, reduced sensitivity to pH variations, improved cycle life, reduced polymer degradation, enhanced mechanical strength, and greater cycle life. A key embodiment of key of the hetero-ionomeric membranes made in accordance with this invention is that at least one characteristic parameter between the two ionomers exhibits different optimum operating conditions [FIG. 462E] such as conductance, flexibility, durability, power cycling life, use life as a function of pH, temperature, humidity, or current density.

In one class of embodiments made in accordance with this invention, the membrane is formed with permanent fillers added prior to molding or casting the film into its final morphology and stoichiometry. Permanent fillers made in accordance with invention include bismuth compounds, graphene oxides, carbon nanotubes, silicates, zirconium, metal-organic-frameworks (MOFs), tungsten, and zeolites.

In one set of embodiments, bismuth compounds [FIG. 433A] introduced into the polymer matrix act as reinforcing agents, improving the mechanical strength and durability of the membrane, a feature particularly important for maintaining membrane integrity under operational stress and high-temperature conditions. In one embodiment, the incorporation of bismuth permanent fillers also enhances the flexibility and toughness of the membrane, reducing the likelihood of cracking or tearing. Bismuth compounds incorporated as nanoparticles also create a more uniform and finely structured membrane matrix, enhancing the dispersion of the fillers and improving the overall performance of the membrane.

In another embodiment, the incorporation of bismuth compounds into the matrix also invoke changes in the morphology of the membrane, such as pore size and distribution, beneficially influencing the membrane's transport properties and improving its overall efficiency. Bismuth enhances chemical stability, rendering making the film more resistant to degradation by chemical species such as free radicals, acids, or bases. Bismuth compounds can also be included in a nanoparticle coating or embedded into the catalyst layer. For example, made in accordance with this invention the addition of these bismuth compounds into the cathode catalyst layer (CCL) accelerate the oxygen reduction reaction (ORR), the rate limiting reaction in a PEM fuel cell.

In another set of embodiments made in accordance with invention, graphene oxides (GO) are introduced into the membrane's polymeric matrix. Graphene oxides [FIG. 433A] may be functionalized by acids such as sulphonic or phosphonic acid, by acid sidechains, or integrated with polysulfone can significantly enhance the performance of ion exchange membranes (IEMs) in fuel cells and other applications.

In one set of embodiments, highly proton-conductive sulphonic acid groups (—SO₃H) are used to functional GOs, increasing proton conductivity and improving the operational efficiency of proton exchange membrane fuel cells (PEMFCs). Similarly, phosphonic acid groups (—PO₃H₂) also made in accordance with this invention also enhance proton conductivity enhancing the membrane's ability to conduct protons and improving overall fuel cell performance.

In another embodiment acidic functional groups attached to membrane bound GOs are added to enhance proton hopping mechanisms, i.e. where protons are transferred from one functional group to another, significantly boosting the overall proton conductivity of the membrane. Furthermore the presence of functional groups form continuous pathways for proton transport reducing membrane resistance, leading to higher efficiency and reduced self heating.

Acid functionalization of graphene oxides made in accordance with this invention also enhances the chemical stability of a ion exchange membrane. Specifically, the presence of strong acidic groups like sulphonic and phosphonic acids resist oxidative degradation, thereby maintaining membrane integrity over prolonged use in aggressive fuel cell environments. In particular, functionalizing GOs improves the chemical stability of the membrane, making it more resistant to degradation from reactive species and extending the operational lifetime of the membrane.

Furthermore, functionalizing GOs with hydrophilic groups such as sulphonic, phosphonic, or phosphoric acids enhances the water retention capability of the membrane. Adequate water content is essential for maintaining high proton conductivity and preventing membrane dehydration, which can lead to reduced performance and durability. Functional groups such as carboxyl, hydroxyl, and sulphonic acids introduced by the methods described herein are hydrophilic, meaning they can attract and retain water molecules. This is beneficial for maintaining the hydration levels necessary for efficient proton conduction.

Membrane swelling in the presence of water made in accordance with this invention is controlled by the type and density of functional groups. Properly balanced, water retention can enhance proton conductivity without compromising mechanical strength. Moreover, as a unique embodiment enhanced water retention is counterbalanced by the mechanical rigidity and structural support of the inert skeletal structure disclosed herein, whereby the tendency for membrane swelling, water logging, and film deformation are suppressed.

Acidic functional groups bonded to graphene oxide made in accordance with this invention increase the ion exchange capacity of the IEM film. This is particularly beneficial in applications where selective ion transport is crucial, such as in electrodialysis or redox flow batteries. Functionalized GOs also reduce the fuel crossover. e.g. hydrogen or methanol through the membrane, enhancing fuel cell efficiency, preventing performance losses, and suppressing ionomer and catalyst degradation.

Another aspect of membranes integrating graphene oxides made in accordance with this invention is tailored morphology. Specifically, the integration of functionalized GOs forms well-defined nanostructures within the membrane facilitating enhanced proton transport while maintaining mechanical integrity. Polysulfone is known for its excellent mechanical properties and thermal stability. Integrating GOs with polysulfone in accordance with this invention produces mechanically robust membranes able to withstand the harsh operational conditions of fuel cells.

In another embodiment of this invention, the introduction of functionalized graphene oxides can also promote the formation of layered structures, further enhancing proton conductivity through contiguous porous channels while maintaining mechanical strength. Functionalized GOs detailed herein also function as molecular reinforcing agents within the polymer matrix, enhancing the mechanical strength and durability of the membrane. This is particularly important for maintaining structural integrity under operational stress.

In another embodiment, functional groups like sulphonic and phosphonic acids attached to a graphene oxide substrate improve the thermal stability of an ionomeric membrane, especially beneficial in applications where an IEM is subjected to high temperatures, thereby ensuring consistent performance and longevity. Enhanced thermal stability also means that the membrane is less likely to decompose at high temperatures, ensuring long-term durability and reliability.

Lastly, the introduction of functionalized graphene oxides into the membrane in accordance with this invention can be tailored to selectively allow the transport of protons while blocking other ions. This selectivity is crucial for maintaining the efficiency of the fuel cell by preventing the crossover of unwanted ions. By enhancing ion selectivity, functional groups can also suppress fuel crossover and the adverse effects therefrom.

### Permanent Fillers.

During membrane fabrication, permanent fillers may be added to the mold compound of any ionomeric polymer to enhance performance. Permanent fillers made in accordance with invention include bismuth compounds, graphene oxides; carbon nanotubes; silicates and zeolites; zirconium, tungsten and transition metals; metal-organic-frameworks (MOFs); nanostructures including PMMA, POSS, nanofibers and nanoparticles; polyoctahedral and double-decker silsesquioxanes (POSS, DDSQ); and functionalized triazines frameworks.

### Bismuth Compounds:

One category of permanent filler depicted in FIG. 433A is compounds of bismuth. Bismuth, the most metallic like chemical element of the nitrogen group, is a post transition metal in group 15 (classic periodic group V) able to stably bond with carbon, oxygen and hydrocarbon compounds and polymeric matrices. Although a variety of electrically active bismuth compounds exist, two variants demonstrated to contribute to ionic conduction include bismuth trimesic acid (Bi-BTC) 6400 and bismuth molybdate (Bi₂O₃·nMoO₃) 6401 where n=3 corresponds to α=(—Bi₂Mo₃O₁₂); n=2 corresponds to the compound β=(—Bi₂Mo₂O₉), and n=1 corresponds to the compound γ=(—Bi₂MoO₆). These bismuth compounds may attach to ionomeric acids groups such as sulfonic acids, phosphonic acids, phosphoric acids, or other acids via a hydrocarbon (HC) sidechain or ligand. For example, bismuth trimesic acid (Bi-BTC) 6400 can bond to sulfonic acid to form the ionomeric permanent filler (Bi-BTC-HC—(SO₃)⁻). In another exemplary bismuth molecule, bismuth molybdate (Bi₂O₃·nMoO₃) 6401 is bound to sulfonic acid via a hydrocarbon (HC) sidechain or ligand acid to form the ionomeric permanent filler ((Bi₂O₃·nMoO₃)—HC—(SO₃)⁻).

Made in accordance with this invention, bismuth compounds introduced into the polymer matrix act as reinforcing agents, improving the mechanical strength and durability of the membrane, a feature particularly important for maintaining membrane integrity under operational stress and high-temperature conditions. The incorporation of bismuth permanent fillers also enhances the flexibility and toughness of the membrane, reducing the likelihood of cracking or tearing. Bismuth compounds incorporated as nanoparticles also create a more uniform and finely structured membrane matrix, enhancing the dispersion of the fillers and improving the overall performance of the membrane.

In another embodiment, the incorporation of bismuth compounds into the matrix also invoke changes in the morphology of the membrane, such as pore size and distribution, beneficially influencing the membrane's transport properties and improving its overall efficiency. In one class of embodiments made in accordance with this invention, the membrane is formed with permanent fillers added prior to molding or casting the film into its final morphology and stoichiometry.

Made in accordance with this invention, bismuth compounds introduced into the polymer matrix act as reinforcing agents, improving the mechanical strength and durability of the membrane, a feature particularly important for maintaining membrane integrity under operational stress and high-temperature conditions. In one embodiment, the incorporation of bismuth permanent fillers also enhances the flexibility and toughness of the membrane, reducing the likelihood of cracking or tearing. Bismuth compounds incorporated as nanoparticles also create a more uniform and finely structured membrane matrix, enhancing the dispersion of the fillers and improving the overall performance of the membrane.

In another embodiment, the incorporation of bismuth compounds into the matrix also invoke changes in the morphology of the membrane, such as pore size and distribution, beneficially influencing the membrane's transport properties and improving its overall efficiency. Bismuth enhances chemical stability, rendering making the film more resistant to degradation by chemical species such as free radicals, acids, or bases. Bismuth compounds can also be included in a nanoparticle coating or embedded into the catalyst layer. For example, made in accordance with this invention the addition of these bismuth compounds into the cathode catalyst layer (CCL) accelerate the oxygen reduction reaction (ORR), the rate limiting reaction in a PEM fuel cell.

Bismuth enhances chemical stability, rendering making the film more resistant to degradation by chemical species such as free radicals, acids, or bases. Bismuth compounds can also be included in a nanoparticle coating or embedded into the catalyst layer. For example, made in accordance with this invention the addition of these bismuth compounds into the cathode catalyst layer (CCL) accelerate the oxygen reduction reaction (ORR), the rate limiting reaction of a PEM fuel cell. Applications of bismuth compounds in ionomeric membranes include enhancing proton exchange membranes (PEMs) in fuel cells to improve their efficiency, durability, and performance; enhancing the efficiency of water splitting by improving ion conductivity and catalytic activity in water electrolyzers; improve ion transport and overall battery performance in batteries, and in enhance sensitivity and selectivity for chemical sensors.

### Graphene Oxides:

In another set of embodiments made in accordance with invention, graphene oxides (GO) are introduced into the membrane's polymeric matrix. The graphene oxides shown in FIG. 433A may be functionalized by acids 6410 such as sulphonic acid (GO-SA) or phosphonic acids (GO-PA), by fluorocarbon sidechains (GO-FC-SA) 6412, or integrated with polysulfone (GO-PSf) 6411 can significantly enhance the performance of ion exchange membranes (IEMs) in fuel cells and other applications.

Specifically acid groups 6410 such as sulphonic acid (GO-SO₃H) are highly proton-conductive. When GOs are functionalized with sulphonic acid, the proton conductivity of the membrane increases, which is crucial for the efficient operation of proton exchange membrane fuel cells (PEMFCs). Similarly, other acid groups 6410 comprising phosphonic acid (GO-PO₃H₂) also contribute to proton conductivity, and their incorporation can enhance the membrane's ability to conduct protons, improving overall fuel cell performance.

Acidic functional groups facilitate proton hopping mechanisms, where protons are transferred from one functional group to another. This can significantly boost the overall proton conductivity of the membrane. Furthermore the presence of functional groups form continuous pathways for proton transport reducing membrane resistance, leading to higher efficiency and reduced self heating.

Acid functionalization of graphene oxides made in accordance with this invention also enhances the chemical stability of a ion exchange membrane. Specifically, the presence of strong acidic groups like sulphonic and phosphonic acids resist oxidative degradation, thereby maintaining membrane integrity over prolonged use in aggressive fuel cell environments. In particular, functionalizing GOs can improve the chemical stability of the membrane, making it more resistant to degradation from reactive species such as radicals and extending the operational lifetime of the membrane.

Furthermore, functionalizing GOs with hydrophilic groups such as sulphonic, phosphonic, or phosphoric acids enhances the water retention capability of the membrane. Adequate water content is essential for maintaining high proton conductivity and preventing membrane dehydration, which can lead to reduced performance and durability. Functional groups such as carboxyl, hydroxyl, and sulphonic acids are hydrophilic, meaning they can attract and retain water molecules. This is beneficial for maintaining the hydration levels necessary for efficient proton conduction.

Membrane swelling in the presence of water made in accordance with this invention is controlled by the type and density of functional groups. Properly balanced swelling can enhance proton conductivity without compromising mechanical strength. Moreover, as a unique embodiment enhanced water retention is counterbalanced by the mechanical rigidity and structural support of the inert skeletal structure disclosed herein, whereby the tendency for membrane swelling, water logging, and film deformation are suppressed.

Acidic functional groups bonded to graphene oxide increase the ion exchange capacity of the IEM film. This is particularly beneficial in applications where selective ion transport is crucial, such as in electrodialysis or redox flow batteries. Functionalized GOs also reduce the fuel crossover. e.g. hydrogen or methanol through the membrane, enhancing fuel cell efficiency, preventing performance losses, and suppressing ionomer and catalyst degradation.

Another aspect of membranes integrating graphene oxides made in accordance with this invention is tailored morphology. Specifically, the integration of functionalized GOs forms well-defined nanostructures within the membrane facilitating enhanced proton transport while maintaining mechanical integrity. Polysulfone is known for its excellent mechanical properties and thermal stability. Integrating GOs with polysulfone in accordance with this invention produces mechanically robust membranes able to withstand the harsh operational conditions of fuel cells.

The introduction of functionalized graphene oxides can also promote the formation of layered structures, further enhancing proton conductivity through contiguous porous channels while maintaining mechanical strength. Functionalized GOs also function as mollecular reinforcing agents within the polymer matrix, enhancing the mechanical strength and durability of the membrane. This is particularly important for maintaining structural integrity under operational stress.

Functional groups like sulphonic and phosphonic acids attached to a graphene oxide substrate improve the thermal stability of an ionomeric membrane, especially beneficial in applications where an IEM is subjected to high temperatures, thereby ensuring consistent performance and longevity. Enhanced thermal stability also means that the membrane is less likely to decompose at high temperatures, ensuring long-term durability and reliability.

Lastly, the introduction of functionalized graphene oxides into the membrane in accordance with this invention can be tailored to selectively allow the transport of protons while blocking other ions. This selectivity is crucial for maintaining the efficiency of the fuel cell by preventing the crossover of unwanted ions. By enhancing ion selectivity, functional groups can also suppress fuel crossover and counter adverse effects therefrom.

Carbon Nanotubes: As an embodiment of this invention carbon nanotubes (CNTs), whether a pristine CNT 6420, a nanocoated CNT 6421, or a functionalized CNT 6422, offer unique properties that can significantly alter and improve the performance of ion exchange membranes (IEMs) in fuel cells and other applications. By introducing permanent fillers containing CNTs into an ion exchange membrane in accordance with this invention, numerous benefits include enhanced proton efficiency; enhanced thermal stability; reduced fuel crossover; improved water management; and enhanced electrocatalytic activity.

Without functionalization, pristine CNTs 6420 create pathways in a polymeric matrix that improve proton transport due to high surface area and excellent thermal and electrical conductivity. Depending on the polymer, pristine CNTs interstitial to a membrane may enhance mechanical properties by acting as reinforcing agents within the membrane matrix similar to the action of carbon fibers, providing structural support and increasing tensile strength. Because of their inability to bond directly onto a polymer's lattice, enhancement in a film's tensile strength is minimal. Pristine CNTs have inherently high thermal stability, which helps maintain the integrity of the membrane under thermal stress. Pristine CNTs can also contribute to reducing methanol crossover by enhancing the barrier properties of the membrane and in maintaining an optimal water balance within the membrane, crucial for consistent performance in fuel cells. CNTs also enhance electrocatalytic activity, aiding in the overall reaction kinetics within the fuel cell.

Although pristine CNTs 6420 can improve electrical, mechanical, chemical, and thermal properties of an ionomeric polymer, in their native form, the poor wettability, weak interfacial boding, and hydrophobicity of carbon nanotubes are unable to strengthen a material matrix. In accordance with this invention, one means to enhance the surface reactivity of CNT is by coating its surface with nanocoatings of metals, metal alloys, and metal polymers. The resulting nanocoated CNTs 6421 are able to enhance the electrical, thermal, catalytic, and ionomeric properties of pristine nanotubes by facile coating processes. The nanocoating process may involve electroplating, electroless plating, and ultrasonic spray atomization processes, primarily of silver (Ag), copper (Cu), nickel (Ni), cobalt (Co), gold (Au), and various metallic alloys such as nickel-phosphorus (Ni-P), nickel-cobalt (Ni-Co), and nickel-cobalt-phosphorus (Ni—Co—P). By improving the surface reactivity nanocoated CNTs are better suited as a permanent filler in membranes featuring magnetic and ferromagnetic, electrically and thermally conductive properties, and catalytic capabilities.

The high catalytic activity and thermal conductance of metal nanocoated CNTs is similar to fillers of metal-organic-frameworks (MOFs). In one embodiment the addition of nanocoated CNTs into a membrane's ionomeric polymeric matrix equilibrates temperature gradients within the polymer. By introducing scavenger metal coated CNTs such as nickel and cobalt into the membrane, its membrane nanocoating, or into the catalyst layer, toxic carbon monoxide can be captured before doing damage to ionomers and catalysts. Made in accordance with this invention, the inclusion of a low density of platinum, palladium, or titanium coated CNTs can also suppress fuel cross over converting stray hydrogen into protons within the film's atomic matrix enhancing fuel cell conversion efficiency and further suppressing the formation of damaging peroxides (H₂O₂).

A variant of a nanocoated CNT also shown in FIG. 433A is a functionalized CNT 6422 where the surface of the carbon nanotube is modified to attach to various organic functional groups or inorganic compounds, salts or crystals. In various embodiments functional groups such as sulfonic acid, carboxyl, or amine groups can be attached to CNTs to improve their proton conductivity. These functional groups facilitate the transport of protons through the membrane, enhancing the overall efficiency of the fuel cell.

Structurally, the CNT bound functional groups interact with the polymeric matrix of the membrane, leading to better dispersion, stronger interfacial bonding, and improved mechanical properties of the membrane, thereby making it more durable and resistant to degradation. The introduction of functional groups also improve the thermal stability of the CNTs, in turn enhancing the thermal stability of the ion exchange membrane, a characteristic crucial for applications operating at elevated temperatures. Furthermore, in direct methanol fuel cells (DMFCs), functionalized CNTs reduce methanol crossover creating a more tortuous path for methanol molecules, thereby improving fuel efficiency.

In another embodiment, the hydrophilicity of functionalized carbon nanotubes attract water molecules, improving the hydration of the membrane and thus enhancing its ionic conductivity. Certain functional groups can impart electrocatalytic properties to CNTs, which can be beneficial for reactions occurring at the membrane interface. CNTs can also be used in ion exchange membranes for water purification systems, enhancing ion selectivity and increasing the efficiency of contaminant removal.

As various embodiments of this invention, both functionalized and pristine carbon nanotubes offer unique benefits that can significantly improve the performance of ion exchange membranes in fuel cells and other applications. Functionalized CNTs provide additional chemical functionality that can be tailored for specific needs, while both pristine and functionalize CNTs offer inherent properties that enhance conductivity, mechanical strength, and stability. The benefit of CNT functionalization depends on the functional group itself. These groups include amino, silica, titania, hydroxy-phosphorus, and carboxyl group, along with various exemplary acids including sulfonic acid, phosphonic acid, and phosphoric acids. The role of functionalized of CNTs in an ion exchange membrane depends not only on the functional group but on the application of the membrane.

For example CNTs functionalized by amino groups (CNT-NH₂) 6423a exhibit a variety of changes involving increased hydrophilicity, enhanced chemical reactivity, and improved membrane selectivity, characteristics important in ion exchange membrane based filters such as water desalinization, deionization, aqueous turbidity and solid particulate separation, protein removal, and other cases. Amine-functionalized CNTs can also be used in photocatalytic applications for environmental remediation, such as the degradation of organic pollutants under light irradiation.

An amino group is an organic compound containing nitrogen and hydrogen called amine. Since nitrogen, like oxygen is more electronegative than either carbon and hydrogen, amino groups exhibit some polar character similar to water. The presence of amino groups on the surface of a carbon nanotube modifies the normally hydrophobic character of carbon nanotubes into a hydrophilic CNT, improving their dispersion in aqueous solutions and enhancing its aqueous chemical reactivity. The introduction of amine groups can enhance the gas adsorption and separation capabilities of CNTs, which is useful in applications like hydrogen storage and carbon dioxide capture.

In another embodiment of this invention involving ion exchange reactions (not shown), the combination of both amino and ionomeric functionalized coatings on a carbon nanotube assist in luring water into the vicinity of the ionomer thereby enhancing charge transport and proton exchange. Amino-functionalized CNTs also can form strong interactions with other molecules or materials, enhancing the mechanical properties and selectivity of the membrane, including improving the attachment of CNTs to the polymer's backbone.

Silica functionalized CNTs 6423s exhibit significantly enhanced mechanical strength and durability, improved thermal stability and better resistance to chemical degradation, together rendering membranes containing silica functionalized CNT more robust with longer cycle life. Titania functionalized CNTs 6423t impart antibacterial properties to a membrane, thereby preventing biofouling. Titania can enhance the UV resistance of CNTs, making the membranes more suitable for UV microbe sterilization applications. Titania-functionalized CNTs also exhibit photocatalytic properties, also beneficial for applications like water purification and pollutant degradation. In ion exchange membranes, the antimicrobial and antifouling behavior of titania functionalized CNTs confers enhanced filter performance especially in applications involving effluent filtration or in electrodialysis

Made in accordance with this invention, carbon nanotubes can also be decorated with hydroxy-carbon groups 6423h (CNT-P(OH)₂). These functional groups impart flame-retardant properties to CNTs, enhancing the fire safety of membranes, and improve compatibility of CNTs with other materials, such as polymers, enhancing the overall performance of composite membrane containing CNTs as permanent filers. Unlike the inert carbon surface of a pristine CNT, hydroxy-phosphorus groups can participate in numerous chemical and electrochemical reactions useful in tailoring membrane properties.

In another class of embodiments the CNTs are functionalized only by hydroxide (CNT-OH) groups without the added phosphorus. By themselves, hydroxyl groups enhance the biocompatibility of CNTs, making them more suitable for biomedical applications and also improve the mechanical properties of CNT composites by promoting bonding between the CNTs and the polymer matrix. Hydroxyl-functionalized CNTs also exhibit improved thermal stability, making them suitable for applications that require high-temperature resistance. By acting as catalytic sites, hydroxyl groups enhance the catalytic activity of CNTs in various chemical reactions. Hydroxyl-functionalized CNTs can be used in environmental applications such as pollutant adsorption and water purification due to their enhanced reactivity and adsorption capabilities. Both amine (CNT-NH₂) and hydroxyl (CNT-OH) functional groups play valuable roles in enhancing the properties and functionalities of carbon nanotubes (CNTs) for a wide range of applications.

In another embodiment carboxyl functionalized carbon nanotubes (CNT-C(O)OH) 6423c are used as permanent fillers in ion exchange membranes. Like amino groups, carboxyl groups significantly increase the hydrophilicity of CNTs, improving water permeability in filtration applications and preventing drying out of IEMs in electrochemical applications such as fuel cells. Carboxyl groups also serve as reactive sites for numerous chemical modifications, allowing for the attachment of various functional molecules to tailor the membrane properties. Carboxyl groups can also enhance the dispersibility of CNTs in aqueous and organic solvents, leading to more uniform membrane structures. In one embodiment carbon nanotubes functionalized by a combination of carboxyl groups together with one or more ionomeric acids such as sulfonic acid, phosphonic acid, or others are introduced as permanent fillers during synthesis of an ion exchange membrane. In this scenario the carboxyl group assists in the uniform dispersion of the CNTs throughout the membrane while the acid groups enhance the films conductivity and carrier mobility. Carboxyl-functionalized CNTs can exhibit ion exchange properties, beneficial in water softening and desalination processes and in enhancing IEM efficiency in fuel cells.

In one class of embodiments, the introduction of acid functionalized carbon nanotubes as permanent fillers in an ion exchange membrane offers a number of advantages to film properties including improved conduction and charge transport in a proton exchange membrane (PEM), enhanced hydrophilicity, accelerated catalysis, flame retardancy, corrosion resistance, biocompatibility, improved metal ion coordination, better ion exchange, and improved electrochemical performance.

Examples of acid functionalized CNTs include sulfonic acid (CNT-SO₃H) 6423s, phosphonic acid (CNT-PO₃H₂), and phosphoric acid (CNT-PO₄H₂). The presence of sulfur and phosphor acid groups enhances the proton conductivity of CNTs, making them suitable for use in proton exchange membranes for fuel cells. These acid groups significantly increase the hydrophilicity of CNTs, making them more dispersible in aqueous solutions, beneficial for various applications requiring homogeneous dispersion in water and in polar solvents during fabrication. Acid-functionalized CNTs can act as strong acid catalysts in various chemical reactions, including esterification, alkylation, polymerization, and hydrolysis. They are particularly useful in heterogeneous catalysis.

In other embodiments, acid groups are added as permanent fillers in membranes to better facilitate ion exchange processes useful in water purification, deionization, and softening applications. Acid groups also can enhance the biocompatibility of CNTs, making them more suitable for biomedical applications, and can better coordinate with metal ions, useful in applications like water purification, heavy metal ion removal, and catalysis. Made in accordance with this invention, the incorporation of acid groups can improve the corrosion resistance of CNT-based materials, making them suitable for extended membrane life or used as protective coatings.

The incorporation of acid functionalized CNTs also improve the flame retardant properties membranes and coatings, making them useful to improve membrane safety and in composite materials for fire-resistant applications. Finally acid functionalized CNT materials and membranes enhance electrochemical properties, making them beneficial for use in energy storage devices such as supercapacitors and lithium-ion batteries.

### Other Fillers.

In another set of embodiments a variety of other permanent fillers made in accordance with this invention include silicates and zeolites; metal organic frameworks (MOFs); zirconium, tungsten, and transition metals; and nanostructures, The incorporation of these and related permanent fillers into a polymeric matrix can significantly enhance the electrical, mechanical, thermal, chemical, and structural properties of IEMs. These improvements provide better performance, durability, and efficiency of membranes in various electrochemical applications including fuel cells, super capacitors, batteries, and filters for gas and liquids.

Collectively these benefits can extend the use life of an ion exchange membrane, and thereby reduce the need for frequent replacement and the downtime. associated with swapping out used membranes for new. It also can reduce solid waste and associated recycling costs. Although each item can be described separately, for the sake of brevity come of the fillers have been categorized by their functional similarities, namely silicates and zeolites, and zirconium and tungsten. MOFs and nanostructures are already broad categories and are not combined with other permanent fillers.

In one set of embodiments, silicates and/or zeolites are introduced into the polymer matrix to enhance performance. As a subclass of silicates, zeolite combining quadrivalent silicate anion [SiO]⁴⁻ and the pentavalent aluminate anion [AlO₄]⁵⁻ together forming the silicate superstructure zeolite ([M]⁺)(AlO₂⁻)(SiO₂)ₓ(yH₂O) where the metallic-ion [M]⁺ may comprise monovalent cations such as H⁺, Na⁺, and K⁺; or divalent cations including Mg²⁺ and Ca²⁺. Because of the presence covalently bound aluminum, zeolite is mechanically strong yet having an electrochemical behavior more metal-like than silicates. Because of its structural integrity, zeolite makes a good candidate as a permanent filler in a proton or anion exchange membrane. Both silicates and zeolites are able to form hollow spherical crystals or nanocrystals [FIG. 433B]. The Swiss-cheese-like crystalline structure, referred to as mesopores or mesostructures, is chemically and electrically beneficial as it increases the reactive surface area of the nanosphere while affording the possibility to capture guest molecules like acid or aluminum within its confines. Representative examples made in accordance with this invention include mesostructured cellular foam (MCF), hollow mesoporous silica nanospheres with phosphorus based acid guest molecules such as phosphonic or phosphoric acid; and mesoporous silica honeycombs containing aluminum grafted guest molecules.

Formation of silica base nanoparticles include a number of processes including spherical colloidal silica systems using seeded growth of nanoparticles as; using amino acid-catalyzed (AAC) methods; or by employing water-in-oil reverse microemulsion (WORM). In one embodiment of this invention the combination of a stable covalently-bonded silica molecule matrix with high surface density contains immobile reactants such as acids or metals enables the silicate mesostructure to contribute to conduction and catalytic activity without compromising the structural integrity of the silicate permanent filler.

In another embodiment, zeolite made in accordance with this invention includes a zeolite nanocluster and self-forming zeolitic imidazolate framework (ZIF) 6481 bonded to a polybenzimidazole (PBI) skeleton. The zeolites offer a stable exoskeletal structure with large surface area and the opportunity to host reactive species within the structure such as a metal catalyst atom [FIG. 349]. In one set of embodiments made in accordance with this invention permanent fillers comprising silicates and zeolites enhance ionic conductivity through additional pathways for ion transport provided by the permanent filler and by the release of additional charge carriers such as protons donated into solution by ionization of silicate-bound or zeolite-bound immobile acids. As such, the nanoparticles act as extra ionomers but do not interfere with the structural integrity of the inert hydrophobic polymer forming the backbone of the membrane.

Other benefits of silicates and zeolites include reinforcing the membrane structure, enhancing its tensile strength and flexibility by creating cross linking bonds to adjacent polymer backbones otherwise not secured to one another. In this manner the fillers improve the microstructure of the membrane by creating a more uniform and interconnected network as well as improving temperature stability. Overall, the addition of silicates and zeolites into an ion exchange membrane made in accordance with this invention improve the magnitude and selectivity of ion transport, reducing crossover, enhancing efficiency, and reducing waste heat. When added into the CCM catalyst layer or an optional membrane nanocoating, the presence of the silicates and zeolites can improved interfacial charge transfer, enhance catalysis, and provide added protection against the diffusion of gaseous environmental toxins such as nitric oxide (NO) otherwise able to damage or disable catalytic metals.

In another set of embodiments, zirconium, tungsten and transition metals are introduced into the polymer matrix in the exemplary forms of metal oxides, tungsten carbide (WC), tungsten nanoparticles 6471, and phosphotungstic acid 6470. Tungsten molecules made in accordance with this invention when included within a polymeric membrane improves conductivity and mechanical strength of the film.

Aside from enhancing conductivity and providing structural support molecules, metals, metal-oxides and metallic quasi-crystals comprising transition metals also function as catalysts useful in the synthesis of ion exchange membranes and as electrochemical components in the CCM in the operation of a fuel cell or an ionic filter membrane. For example, as a catalyst zirconium is used for polymerizing alkenes to produce polyethylene and polypropylene, a part of membrane synthesis. Tungsten is also well known for its catalytic properties, especially in reactions involving hydrogenation, dehydrogenation, and other chemical processes. Tungsten's catalytic activity is often enhanced when it is in the form of tungsten carbide (WC). This form is particularly useful in industrial applications such as hydrocracking but may also be applied to ionic membrane filtering.

In the context of this application, the catalytic properties of tungsten, zirconium, and other catalytic metals can be used in a variety of ways, either in the catalyst layers of a CCM, in nanocoatings of the ionomeric membrane, or within the ionomeric membrane itself. For example, in one set of embodiments a zirconium nanocluster or tungsten quasi-crystal such as tungsten carbide (WC) is introduced into an ion exchange membrane as a permanent filler during synthesis. The role of these membrane permanent fillers within the polymeric matrix is not only to enhance conductivity by increasing the density and number of charge transport pathways to reduce tortuosity, but to secondarily function as a safeguard for reducing fuel crossover. In this function, stray hydrogen escaping the catalyst in the anode and diffusing into the membrane encounters the catalytic permanent filler which converts the hydrogen into protons and electrons thereby increasing the conversion efficiency and reducing risk of hydrogen peroxide formation in the cathode.

In yet another embodiment, permanent fillers of zirconium and tungsten compounds are added into a nanocoating deposited on the cathode side of the membrane. In this case the catalysts are used to sequester or dissociate environmental gaseous toxins such as carbon monoxide (NO) present in the oxygen supply, generally contained within atmospheric air used as the oxygen source in open cathode fuel cells.

In other embodiments of this invention, zirconium, tungsten or other transition metal compounds are used in the catalyst coated membrane (CCM), also known as the membrane electrode assembly MEA3. The addition of the transition metal catalyst into the catalyst layer (CL) promotes more efficient proton generation from hydrogen or methanol in the anode catalyst layer (ACL), a reaction referred to as the hydrogen oxidation reaction (HOR) or hydrogen evolution reaction (HER). For HOR reactions, catalytic efficacy depends on a catalysts metal's ability to adsorb and dissociate hydrogen molecules and facilitate the transfer of protons and electrons. As tungsten in the form of tungsten carbide (WC) exhibits hydrogen catalytic properties similar to platinum, WC is particularly effective in HER due to its ability to adsorb hydrogen and facilitate proton generation.

The oxygen reduction reaction (ORR) at the cathode of a proton exchange membrane fuel cell (PEMFC) is a key reaction determining the overall efficiency and performance of the fuel cell. Catalysts are crucial for enhancing the efficiency of this reaction. Since the HOR reaction and ORR are complementary reactions in a REDOX reaction pair, the optimum catalyst metal is not necessarily the same. Due to the high cost and scarcity of platinum, alternative catalysts or enhancing the performance of platinum by combining it with other metals are now needed.

More generally any non-radioactive non-corrosive transition metal may be used in the catalyst layer of a fuel cell. In one set of embodiments transition metals such as nickel, copper, chromium, cobalt, tungsten, and the abundant elements of iron along with titanium, manganese, zirconium, vanadium, and chromium are used in addition to or to substitute more expensive precious metals of gold, silver, platinum, and palladium.

In another embodiment of the invention, platinum catalysts in the ACL and/or the CCL are replaced with platinum alloys of platinum-cobalt (Pt—Co); platinum-nickel (Pt—Ni); and platinum-iron (Pt—Fe). Non-platinum catalysts made in accordance with this invention comprise transition metal-nitrogen-carbon (TM-N-C) catalysts coordinated with nitrogen and embedded in a carbon matrix including exemplary metal compounds such as iron (Fe—N—C) or cobalt (Co—N—C). In another embodiment the catalysts comprise metal oxides such as manganese oxide (MnO₂), cobalt oxide (Co₃O₄), iron oxide (Fe₃O₄), and titanium dioxide (TiO₂).

As an embodiment of this invention to enhance catalytic activity, especially for the oxygen reduction reaction (ORR) in the cathode catalyst layer (CCL), tungsten carbide (WC) is included either as a primary catalyst or as a co-catalyst used in conjunction with platinum or metal-nitride, or metal-oxide compounds intermixed within in a carbon matrix. WC is advantageous as it emulates many platinum like characteristics including conductance, structural integrity, thermal and chemical stability, but at substantially lower cost.

In another set of embodiments zirconium is included in the catalyst layer, not as a primary catalyst but as a co-catalyst. Doping pure zirconium into transition metal catalysts can improve the overall mechanical stability and electronic properties of the catalyst layer while enhancing dispersion and uniformity of the active sites. Zirconium doping of WC stabilizes the carbide phase, preventing the formation of undesirable oxide layers that could deactivate the catalyst. Zirconium also enhances resistance to corrosion and oxidation, extending the catalyst's operational lifespan. Together, Zr-WC exhibits modified surface properties such as increased surface area, increased active site density, and better adsorption and activation of oxygen molecules, important for efficient oxygen reduction reactions.

In another embodiment zirconium oxide (ZrO₂) is added to support for platinum or other transition metals, providing stability and enhancing the dispersion of the catalytic particles. Alternatively, incorporation of ZrO₂ into tungsten carbide provides a high surface area support structure for WC nanoparticles, enhancing the surface area and maximizing the number of active sites available for ORR. The strong interactions between ZrO₂ and WC also enhance the stability of the catalyst, preventing aggregation and sintering of tungsten carbide nanoparticles under operational conditions while enhancing catalysis. ZrO₂, known for its excellent chemical stability and resistance to acidic and basic environments, thereby protects the active WC catalyst sites from harsh conditions often encountered in fuel cells and other electrochemical systems, prolonging the catalyst's life. Moreover, ZrO₂ has a high oxygen storage capacity facilitating a steady supply of oxygen to the active catalytic sites during the ORR.

In another set of embodiments made in accordance with this invention, metal organic frameworks (MOFs) [FIG. 433B] such as exemplary MOF quasi crystals, zirconium metal clusters, metal clusters, and MOF prisms and lattices form an entire array of metallic dopants applicable as permanent fillers within an ionomeric polymer membrane, as catalysts in CCM catalyst layers, and as toxic scavengers within membrane nanocoatings. Functionalization of MOFs include chemically active sites on the vertices of the matrix [FIG. 319], as functional groups attached via sidechains to organic ligands [FIG. 313], or by guest molecules captive within the matrix [FIG. 316].

In another embodiment made in accordance with this invention, the elements controlling conduction, chemical bonding, and catalytic activity can be independently selected or even combined within the same MOF. In one embodiment, a MOF used as a permanent filler in an IEM or PEM includes ionomeric groups or acids to enhance conductivity along with catalysts used to suppress fuel crossover. In yet another embodiment, a nanocoating includes MOFs containing both scavenger metals preventing nitric oxide (NO) poisoning and active catalyst metals such as platinum to enhance reaction rates and conversion efficiency.

In another set of embodiments, nanostructures are introduced as permanent fillers into a polymer matrix to beneficially modify its structure, stoichiometry, porosity, chemical reactivity, mechanical strength, durability, thermal resistance, electrical conductivity, and other material properties. Various embodiments of nanostructures used as permanent fillers made in accordance with this invention [FIG. 433B] include nanofibers introduced into the polymeric matrix to provide enhanced structural rigidity and strength and to improve thermal conductivity; coated composites which may used as a permanent filler or form ionomeric membranes directly; and metal oxide nanoparticles which may be coated on a membrane or included within the mold as a permanent membrane filler. Other nanostructures include metal nanoclusters, PMMA nanospheres, and nano-barriers.

All the nanostructures described herein may in one set of embodiments be added into the polymer matrix during molding as permanent fillers; or in another set of embodiments may be used as a component of membrane nanocoatings; or in a third set of embodiments may be an additive to CCM catalyst layers. In various embodiments thereof, these nanostructures may be applied separately or combined with skeletal membrane support, the sacrificial pore process, with any other permanent filler. They may included in homo-ionomer and hetero-ionomer films comprising any described polymer, hybrid polymer, copolymer, or block polymer.

In another set of embodiments made in accordance with this invention nanofibers (NF), may be used to directly form a membrane, or alternatively may be used as a permanent filler within a membrane. The nanofibers may form a entangled web with a copolymer whereby material strength is increased even if the two polymers do not chemically bond to one another. In another embodiment the nanofibers are fabricated using electrospinning [FIG. 372] and subsequently crushed to reduce the average length of the nanofibers prior to loading them into the mold for casting thereby limiting the average length of the fibers and preventing their protrusion from the molded film. Made in accordance with this invention polymers able to form reasonably strong extruded or electrospun fibers including polyurethane (PU); polypropylene (PP); polyimide (PI); and poly(ethylene terephthalate) (PET). Other polymers such as polystyrene (PS); polyvinylidene chloride (PVDC); poly(methyl methacrylate) (PMMA); and polycarbonate (PC); while able to be functionalized by ionomeric groups do not form strong flexible nanofibers and are less adaptable for extrusion or electrospinning processes but still may be employed.

In one set of embodiments, permanent fillers comprising polyurethanes (PU) able to form strong extruded or electrospun fibers are functionalized by incorporating ionomeric groups modifying the polymer backbone or by adding functional groups during the polymerization process. In another set of embodiments, polypropylene (PP) permanent fillers are functionalized with ionomeric groups during synthesis by blending with copolymers that contain ionomeric groups.

In another set of embodiments, polyimide (PI) permanent fillers offering excellent thermal stability and mechanical properties able to form strong nanofibers are functionalized by incorporating ionomeric groups during the polymerization process. In another embodiment poly(ethylene terephthalate) (PET) a thermoplastic polymer offering excellent mechanical properties and chemical resistance is functionalized during copolymerization with monomers that contain ionomeric groups to enhances its conductivity, adhesion properties, and compatibility with other materials then used to synthesize nanofiber based membranes or to act as a permanent filler in an IEM.

In another class embodiments involving nanostructuring [FIG. 433B], polymer nanofibers (NF) are coated with a nanocoating to alter in surface properties, wettability, and conductivity. The fibers are first synthesized by extrusion such as electrospinning, by precipitation of colloidal suspensions, or by stretch-expansion process as exemplified by extended polytetrafluoroethylene (ePTFE). In on set of embodiments these nanofibers include graphene nanofibers (GNs); graphene oxides (GO); polystyrene; poly(I)-lactide (PLLA); poly(vinylidene fluoride) (PVDF); polyacrylonitrile (PAN); poly(vinyl alcohol) (PVA), chitin; PVA-chitosan; gelatin, polycaprolactone (PCL); PCL-gelatin; polylactic acid (PLA); silk; or the corn-protein zein.

After synthesis, the nanofibers are coated by various beneficial materials including a nanoparticle slurry of PTFE and PFSA molecules, by alloys or oxides of transition metals and catalysts such as platinum, by cross linkers and molecular glues such as glutaraldehyde, by polymer bonding agents such as polydopamine and reduced graphene oxide (rGO), or by various ligands. In one embodiment, coating may be performed by soaking the fibers in a liquid suspension; by deposition using sputtering or chemical vapor deposition (CVD); or by ultrasonic spray coating. In various embodiments, nanofiber annealing depends on the materials employed whereby molding and cross linking of the nanofibers may precede the coating process, or alternatively be performed after coating. While the nanocoating may comprise catalytic or ionomeric functional groups, in biofilters it may also include polydopamine (PDA) to improve biocompatibility of graphene nanofibers (GNs) or include antibacterial coatings such as tetracycline hydrochloride.

In one embodiment chitin nanofiber modified by surface modification with polydopamine produces nanofiber-polydopamine composite able to remove dyes such as methyl blue and various metals such as Fe³⁺, Mn²⁺, Cu²⁺, and Ni²⁺ from wastewater. In one embodiment the filter membrane is reinforced by the endoskeleton described herein to provide added mechanical support. Other nanocomposites [FIG. 294] may comprise nanospheres (NS) rather than nanofibers.

In another set of embodiments made in accordance with this invention, metal or metal oxide nanoparticles are included either discretely as permanent fillers loaded in the membrane prior to molding, or attached to carbon nanotubes. Embodiments of metal and metal oxide nanoparticle permanent fillers include platinum amino functionalized nanoparticles (Pt—NH₂ NP) [FIG. 297B], titanium amino functionalized nanoparticles (Ti—NH₂ NP), titanium-tin functionalized nanoparticles (Pt—Sn NP) [FIG. 298], silver (Ag(nanoparticles [FIG. 306A], and zirconium oxide nanospheres (ZrO₂ NS) [FIG. 311]. Other embodiments include metal clusters include chromium terephthalate metal cluster (MIL-101(Cr)) 2153 [FIG. 322]; tungsten carbide (WC) nanoparticles [FIG. 335]; metal-sulfur complexes [FIG. 349]; and platinum titanium dioxide nanoparticles (Pt-TiO₂ NP) 2357 [FIG. 360].

In another set of embodiments made in accordance with this invention, poly(methyl methacrylate) is used to form permanent fillers comprising PMMA nanospheres [FIG. 249] improving proton conductivity in PEMs by creating multiple pathways for proton conduction, thereby reducing the charge transport tortuosity and enhancing the overall conductivity of the membrane. The addition of PMMA nanospheres made in accordance with this invention also enhances the mechanical strength and durability of PEMs improving longevity and reliability of fuel cells often subjected to harsh operating conditions. In another embodiment, PMMA nanospheres used as permanent fillers increases the thermal stability of PEMs rendering membranes more resistant to degradation at higher temperatures, a trait beneficial for fuel cell performance and lifespan. In another embodiment the introduction od PMMA nanospheres into direct methanol fuel cells (DMFCs) helps reduce methanol to maintain the efficiency and performance of the fuel cell. In another embodiment, PMMA nanospheres made in accordance with this invention introduced as a permanent filler in an IEM enhance film water retention thereby maintaining high proton conductivity, especially under low-humidity conditions.

In various embodiments of this invention, PMMA nanospheres are functionalized with various chemical groups thereby tailoring of the membrane properties to meet specific requirements, such as enhancing compatibility with other membrane components or improving specific performance metrics. These PMMA nanospheres can be uniformly dispersed within the polymer matrix of a PEM achieving consistent performance across the entire membrane and preventing localized weaknesses or failures. Moreover, the PMMA nanosphere fillers are chemically stable and resistant to various chemical environments thereby ensuring a PEM maintains its integrity and performance over time, even in the presence of reactive species. Examples of PPMA nanospheres used as permanent fillers include sulfonated poly(methyl methacrylate) (sPMMA) [FIG. 253] and surface functionalized PMMA nanospheres [FIG. 254]. In other embodiments, PMMA forms a porous nanosphere [FIG. 255], a PMMA nanocluster [FIG. 256A[containing ZnS nanospheres or a PMMA nanocluster [FIG. 256B] containing zinc-oxide (ZnO) nanospheres.

In yet another embodiment of this invention, a nano-barrier against methane fuel cross over [FIG. 398] is formed by doping the polymer with polydopamine and ADPS, i.e. the compound 3-(3-aminopropyl) dimethylammonio) propane-1-sulfonateare.

In another set of embodiments [FIG. 433B], polyhedral silsesquioxanes comprising polyoctahedral and double-decker silsesquioxanes POSS and DDSQ 6491 are used as permanent fillers to enhance hydrophilicity and conductivity by creating more pathways for proton transport and reducing the tortuosity of conduction pathways. The nanoscale dispersion of POSS within the polymer matrix also forms well-defined proton-conducting channels, further improving the overall conductivity of the membrane.

In another embodiment of this invention, the addition of POSS and DDSQ and permanent fillers enhance the film's mechanical properties including durability, strength, thermal, and chemical stability, significantly enhancing a membrane's mechanical strength and durability due to the rigid cage-like structure of POSS, as well as reinforcing the polymer matrix, and improving thermal and chemical stability. By enhancing the chemical and thermal stability, POSS-modified PEMs achieve longer operational lifespans, improving reliability in mission critical applications, reducing the frequency of membrane replacement, and lowering overall maintenance costs.

In another set of embodiments POSS permanent fillers made in accordance wit this invention are functionalized with various organic groups, allowing for the customization of the PEMs' properties to suit specific applications including optimizing proton conductivity, improving mechanical properties, and enhancing compatibility with other components of the fuel cell. The ability to tailor the properties of POSS-modified PEMs makes them versatile for different types of fuel cells, including those operating at different temperatures and humidity levels.

### Ionic Liquids.

In another class of embodiments of this invention, the ionomeric polymer membrane is doped with ionic liquid [FIG. 433] to enhance proton density and improve conductivity. For IL doping of proton exchange layers, the magnitude of conductivity modulation depends on the concentration of IL doping and on the chemical species of the IL cation compound but not on the anion composition. A sample of possible IL cations able to be complexed in ionic salt precursors of various ILs include a variety of species:
imidazolium—imidazolium comprises a protonated form of an organic aromatic heterocycle imidazole and ionic liquid cation with a chemical composition [C₃N₂H₃]⁺ abbreviated as [Im]⁺;
pyrrolidinium—pyrrolidinium comprises a protonated form of organic amine heterocycle pyrrolidine and ionic liquid cation having a chemical formulation [(CH₂)₄NH₂]⁺ and the abbreviation [Pyrr]⁺;
pyridinium—pyridinium comprises an aromatic conjugate acid of pyridine and ionic liquid cation having the chemical formulation [C₅H₅NH]⁺ abbreviated as [Pyr]⁺;
ammonium—the subclass ammonium comprises a positively charged polyatomic ion of ammonia and ionic liquid cation having the chemical formulas [NH₃]⁺ or as a quaternary ammonium cation with the form [NR₄]⁺ where R represents one or more hydrogen atoms replaced by organic groups or other compounds;
phosphonium—phosphonium comprises a positively-charged tetrahedral polyatomic ion and ionic liquid cation having the chemical formula [NR₄]⁺ where R represents a hydrogen atone or an alkyl, aryl, or halide group;
sulfonium—sulfonium comprises a positively charged organosulfur compound and ionic liquid cation with a chemical formula [SR₃]⁺ comprising three organic substituents R attached to a central sulfur core;
thiazolium—thiazolium comprises a protonated form of thiazole, a 5-membered heterocyclic sulfur-nitrogen compound and ionic liquid cation having the chemical formula [C₃H₄NS]⁺ and abbreviation [Tz]⁺;
piperidinium—piperidinium comprises a protonated form of the heterocyclic methylated amine piperidine and ionic liquid cation having the chemical formulation [C₅H₁₂N]⁺ abbreviated as [PipH]⁺;
protonated hydrocarbons (carbonium cations)—a broad class of positively charged protonated hydrocarbon solvents and ionic liquid cations referred to collectively as alkali carbonium aka alkanium including methanium, protonated methanol, ethanium, protonated ethanol, propanium, protonated propanol, butanium, protonated butanol, octonium, protonated acetone, protonated acetonitrile, protonated dimethyl sulfoxide [(DMSO)H]⁺, protonated toluene, protonated aniline, and others;
biochemical cations—biochemical cations comprise a diverse class of positively-charged and protonated organic compounds formed by or participating in biochemical reactions including carbonium (described above) and protonated choline [FIG. 406D], along with protonated creatine, protonated arginine, protonated lysine, protonated histidine, etc.;
superbase cations—superbase cations result from superbase reactions where a strong base such as ammonium, phosphonium, sulfonium, phosphazene, amidine, guanidine, and other onium ions becomes protonated forming IL pairs or releasing the sequestered protons thereby influencing ionic conductivity.; and,
poly ionic liquids—copolymers of ionic salts exemplified by vinyl functionalized imidazolium [FIG. 406D] and by vinyl pyrrolidinium including numerous variants mirroring those of their fundamental cation radical offer added control over ionomeric conductivity, thermal stability, and changing hydration.

Many but not all cations of ionic liquids comprise onium ions representing a broad class of cations derived from neutral molecules through the addition of a proton (H⁺) or other cations. Onium ions contain a central atom, often of nitrogen, phosphorus, sulfur, or oxygen, carrying a positive charge. Of the foregoing, some cationic superbases are onium ions, but not all superbases are onium ions.

In one embodiment, any of the ionic liquids may be introduced into a membrane and sealed from leakage laterally by the inert skeletal pillars [FIG. 422B] and sealed from the gas diffusion layer by a nanocoating [FIG. 422C] or a catalyst layer designed to prevent IL seepage.

### Applications.

In other embodiments of this invention, a variety of exemplary applications of the fabricated membranes are disclosed herein. One embodiment of the application [FIG. 434A] includes a fixed array of fuel cells supplied by hydrogen and converted into electricity concurrently transferred to an energy storage buffer such as a lithium ion battery array through a charge transfer regulator (QXR), where the buffer powers an electrical load without directly connecting the load to the fuel cell and where the QXR ensure the fuel cell doesn't over drive or overcharge the buffer and that the buffer doesn't draw more current than the fuel cell can reliably supply without suffering significant voltage sag.

In another embodiment [FIG. 434B], the aforementioned fuel cell system is modified so that the fuel cell is not a fixed array but comprises a stack of smaller fuel cells called micro-stacks (μstacks) where the configuration such as the number of μstacks connected in series is dynamically altered by a fuel cell control module to compensate for the impact of current, humidity, and temperature variations on the aggregate fuel cell stack voltage.

In a related embodiment [FIG. 434C] current delivered from the energy storage buffer to the electrical load passes through a buffer-load access circuit preventing the electrical load from drawing too much current from the buffer and preventing reverse current flow from the load into the buffer. In another related embodiment electrical current from an external source and not the fuel cell is conditioned and used to charge the energy storage buffer through a circuit referred to as energy recovery.

In another embodiment an intelligent buffered fuel cell [FIG. 535] comprises a autonomous unit with hydrogen and oxygen ingress and egress ports along with refrigerant input and output connections for temperature regulation. The energy recovery module includes a DC input for renewable or backup supplies, an AC input (labelled pluggable power) for grid and generator connections, and an energy recovery input for intermittent regenerative or energy harvesting power sources. The buffer load access circuit is exemplified by a motor as an electrical load including a flyback rectifier diode for regenerative power transfer.

In another embodiment [FIG. 436] a series of fuel cells includes a bypass transistor controlled by a voltage monitor acting as power multiplexer, the output of which us transferred into a dual mode constant-current constant-voltage (CI-CV) battery charger fed through an intervening current limiter to prevent excessive fuel cell current draw. The circuit includes an exemplary 1s2p battery array with a low-side bidirectional battery disconnect switch and bidirectional bypass switch. Implementation of the bidirectional switches include a body-snatched lateral MOSFET [FIG. 437A] or a two back-to-back trench power DMOSFETs [FIG. 437B]. By combining the disconnect and bypass functions two of the four discrete DMOSFETs can be eliminated to realize the BLA function [FIG. 438] resulting in reduced power loss [FIG. 440] within the power DMOSFET semiconductor switches.

In another embodiment the functional components of the intelligent buffered fuel cell [FIG. 439] include the aforementioned fuel cell array, energy storage buffer, fuel cell control, energy recovery circuit, buffer load access circuit, humidity control, temperature control, fuel management interface, and high voltage isolated intelligent buffer system control unit. A compact packaging of a buffered fuel system [FIG. 445] includes three fuel cell μstacks mounted directly on a thermally conductive or metal plate or shelves. Forced air flows across the exposed surfaces of the μstack to facilitate convective cooling of the μstack. Additional cooling is facilitated by thermal conduction from the μstack into the metal plate which optionally may be actively cooled or temperature regulated. Forced airflow through the cathode of the fuel cell required for oxygen delivery provides another heat transfer path.

In one embodiment the combination of thermal conduction into its backplate, convection across its surface, and forced airflow through its cathode provide three cooperative forms of heat removal from the active fuel cells. By limiting the height of the μstacks the temperature gradient across the stack is limited and heat conduction into the backplane is maximized. In another embodiment the backplane to which the μstacks are attached includes embedded cooling such as liquid heat or refrigerant transfer. In another embodiment, one-or-more series array of electrochemical buffer cells such as lithium ion batteries are connected in series, positioned perpendicular to the baseplate or printed circuit board in an antiparallel arrangement for completing the series connections [FIG. 446, FIG. 447].

In one embodiment, three μstacks are multiplexed [FIG. 441] to maintain a quasi-constant fuel cell output voltage [FIG. 443] and a series connected battery array [FIG. 446] matched to the fuel cell stack voltage range. In another embodiment, four μstacks are multiplexed [FIG. 449] to maintain a quasi-constant fuel cell output voltage [FIG. 450]. In another embodiment, five μstacks are multiplexed [FIG. 452] to maintain a quasi-constant fuel cell output voltage [FIG. 454]. The primary benefit of a dynamically switched array of fuel cells is to adapt to changes in the fuel cell voltage with humidity, temperature, and current.

In principal the number of series connected fuel cells is adjusted to compensate for increases or decreases in their voltage. Assuming every fuel cell membrane in a fuel cell stack operates at the same current density, humidity, and temperature, then all the fuel cells will exhibit approximately the same voltage V_{FC}. As such, the total fuel cell stack of ‘n’ layers will produce an aggregate voltage nV_{FC}. If the voltage V_{FC} declines for any reason, the number of fuel cells ‘n’ in the stack can be immediately increased to compensate for the voltage decline thereby maintain a stable net stack voltage. Conversely if the voltage V_{FC} increases, the number of fuel cells in the stack ‘n’ can be immediately decreased to compensate for the voltage rise, to maintain a quasi-constant stack voltage.

Detailed operation of a dynamic fuel cell is described in a related application entitled “Intelligent Buffered Fuel Cell with Low Impedance” including determining the optimum number of fuel cells for any condition. In this application the number of membranes are not varied individually but in groups of μstacks, e.g. where each μstack contains a preset number of membranes. For example in a twelve-layer μstack a fuel cell stack comprising two μstacks contains n=24 layers, three μstacks comprise n=36, and so on.

As the μstacks in the fuel cell circuit are interconnected or bypassed using low-voltage low-resistance power MOSFETs with low specific-on resistances, there is virtually no power loss introduced into the fuel cell by the switches. By contrast allowing the fuel cell stack voltage to vary widely excludes the use of linear voltage regulation, requiring more complex and costly switching voltage regulation. As switching power supplies include both switching and conduction power losses, their efficiencies cannot compete with the dynamic fuel cell array. Moreover, control of the dynamic fuel cell multiplexer function is trivial, discretely requiring one-or-two comparators and a voltage reference or alternatively an analog-to-digital (ADC) conveniently integrated into the iBFC microcontroller. Although the granularity of the voltage selection using multiplexed μstacks is not as precise as controlling the inclusion or exclusion of individual membranes, so long that a minimum voltage needed to charge the buffer is maintained and the maximum stack voltage, the over-voltage, is held to a minimum, the dynamic fuel cell stack is preferred over a fixed array.

In one embodiment comprising three twenty-one layer μstacks and two switches [FIG. 441], the fuel cell stack may switch between n=42 and n=63 allowing the fuel cell stack voltage to operate between 40V and 24V working down to a fuel cell voltage of V_{FC}=0.4V corresponding to 27% relative humidity [FIG. 443]. Without switching, a fixed 42-layer stack is only be able to function down to V_{FC}≈0.6V or 55% relative humidity. In this manner, the inventive dynamic fuel cell reduces the humidity operating range to half that of fixed array, i.e. from RH=55% to RH=27%. The Vₘₐₓ to Vₘᵢₙ ratio of the fuel cell stack, herein defined as the overvoltage ratio χₒᵥ=Vₘₐₓ/Vₘᵢₙ is equal to χₒᵥ=40V/24V=1.7. This means the peak voltage of the stack Vₘₐₓ which determines the voltage and cost of semiconductor devices in the power path is 1.7× the minimum voltage Vₘᵢₙ=24V. The value of Vₘᵢₙ is unalterably set by the minimum voltage required to fully charge a 24V series array of six Li-ion batteries, i.e. a 6smp battery array irrespective of how many ‘m’ parallel strings are used. With a 40V peak stack voltage, a regulator must employ 50V to 60V power semiconductor transistors. Since the specific on-resistance of a vertical power MOSFET is governed by the ratio

$$[ {R}_{DS} A ] ∝ {( {V}_{B} )}^{2.5}$$

then 50V to 60V devices exhibit specific resistances 1.7× to 2.8× greater than 40V transistors, i.e. double to triple the cost.

In another embodiment of this invention the overvoltage ratio of a dynamic fuel cell stack can be dramatically reduced by using shorter μstacks, i.e. more μstacks but with fewer layers per stack. In one exemplary design, a fuel cell [FIG. 449] comprises four twelve-layer μstacks with a two switch multiplexer able to select between n=36 and n=48, an operating between 32V and 24V, for an overvoltage ratio of only χₒᵥ=32V/24V=1.33. The dynamic array is able to work at V_{FC}=0.5V corresponding to a RH=34%. By contrast using a fixed array of n=36, the fuel cell would only function down to V_{FC}≈0.7V or 78% relative humidity. In a fixed array where n=48, the peak operating voltage of the stack exceeds 44V meaning only expensive 50V or 60V transistors can be used.

In another embodiment, a three-switch power multiplexer enables a dynamic fuel cell capable of changing among 36, 48, and 60 series connected layers in order to electrically compensate against low humidity or high load currents. The fuel stack comprises two 12-layer μstacks and one 36-layer μstacks [FIG. 456] or alternatively five 12-layer μstacks [FIG. 452], three of which are hardwired together. The dynamic stack combines the μstacks with one series connected switch and two bypass switches. In high demand or low humidity conditions, the bypass switches remain open and the one series switch is closed so that all 60 layers participate in supplying electricity to the fuel cell stack. In an intermediate condition, the series switched is opened and the disconnected μstack is bypassed resulting in a n=48 fuel cell stack. In low current and high humidity operation, the closed bypass switch is opened disconnecting two μstacks which are bypassed by a second bypass switch resulting in a n=36 layer fuel cell.

The benefit of this five μstack design made in accordance with this invention is a wide operating range from RH=100% at V_{FC}=0.9V down to RH=27% and V_{FC}=0.4V all while maintaining Vₘₐₓ≤32V with unmatched overvoltage ratio of only χₒᵥ=32V/24V=1.33×. By comparison using a fixed 60-layer stack able to function at RH=27%, the value of Vₘₐₓ=54V with an unacceptably high overvoltage ratio of χₒᵥ=54V/24V=2.25× requiring the use of 80V power MOSFET nearly six times larger and more expensive than 40V power devices.

In one set of embodiments, a dynamic fuel cell comprising n={36, 48, 60} layers and A_{FC}=200 cm² is able to maintain a minimum of 1 kW output power [FIG. 461, FIG. 462] down V_{FC}=0.4V and RH=27%.

In one embodiment [FIG. 455] multiple series-connected μstacks connect to a summing node through an intervening charge transfer regulator (QXR), where the summing node comprises a shared electrical node connecting the QXR to the buffer array and to the electrical load. The inventive QXR comprises a specialized regulator limiting the maximum current out of the fuel cell flowing into the summing node and also preventing overcharging of the buffer. By Kirchhoff's current law, net current flowing into and out of the summing node necessarily must sum to zero. whereby I_{FC}−I_{buf}−I_{L}≡0 or in rearranged terms I_{FC}−I_{buf}=IL.

Since the fuel cell delivers only as much current as the summing node requires but never in excess of the QXR current limit, then when the fuel cell current has a maximum value I_{FC}(max) set by the QXR, whereby I_{FC}(max)=I_{L}, and I_{buf}=0. As there is no ‘net’ average DC current flowing into or out of the buffer cell array, the state-of-charge (SoC) of the buffer remains unchanged, a condition referred to herein as a steady-state or equilibrium.

In another embodiment, the buffered fuel cell powers an electrical load from its buffer not from the fuel cell generating power. Even when the net buffer current is zero, it does not mean that the fuel cell is powering the electrical load directly. Because the fuel cell and QXR have series electrical impedance far greater than the battery buffer stack, any transient load demand is instantaneously supplied by the buffer not by the fuel cell. The discharge spike is soon thereafter countered by the fuel cell replacing the lost charge so that the net change in the buffer's state-of-charge is zero even though it actually occurred in steps locked in tandem. In dynamic operation, power transfer in response to load transients occurs sequentially and out-of-phase where the buffer supplies the majority of the load demand and the fuel cell recharges the buffer thereafter.

Given the phase delay in recharging the buffer, as another inventive embodiment of this invention, the buffered fuel cell provides current to an electrical load at a low impedance. The iBFC thereby functions as a self-recharging or perpetually-charged battery where the buffered fuel cell comprises a stiff voltage source whose voltage doesn't sag or collapse the way a conventional fuel cell does.

The equilibrium condition in the inventive buffered fuel cell also can occur when the QXR is not in current limiting mode. Specifically when the electrochemical buffer is fully charged and its net current is zero (I_{buf}=0) but where the load current required is less than the QXR current limit, i.e. where I_{FC}=I_{L}≤I_{FC}(max) then the fuel cell conducts the same current as the electrical load, thereby charging the buffer with the same net charge as the load removes.

When an electrical load is not demanding significant current, i.e. when I_{L}≈0 or I_{L}<<I_{FC}(max), then the QXR in the inventive buffered fuel cell allocates and delivers all available power to the summing node to safely recharge the buffer where I_{buf}=I_{FC}. Made in accordance with this invention, during charging, two criteria apply: (i) the fuel cell current must not exceed the maximum fuel cell current I_{FC}≤I_{FC}(max), and (ii) the maximum charging current cannot exceed the maximum buffer charging current I_{buf}=I_{buf}(max). In one embodiment, the charge transfer regulator limits its maximum current I_{QXR}(max) to be the lower of the fuel cell and the buffer maximum current limits I_{QXR}=min{I_{FC}(max), I_{buf}(max)}. As implemented, the inventive QXR circuitry need not contain two separate regulators [FIG. 456], although functionally it operates the same as the superposition of the two.

In one embodiment, the QXR current limiter has a single value biased at a preset value. For example, a fuel cell array of area A_{FC}=200 cm² operating at a current density of [I_{FC}/A]=200 mA/cm², has a nominal steady-state current of I_{FC}=(A_{FC})[I_{FC}/A_{FC}]=40 A. In a single-tier buffered fuel cell, the current limit would be set at I_{FC}(max)=40 A. In another embodiment comprising a two-tiered buffered fuel cell system, the QXR current can on demand, be increased to a higher current density, e.g. [I_{FC}/A]=400 mA/cm² provided that either (i) the duration of the higher current is limited, or (ii) a temperature sensor or sensors detect the fuel cell condition and use negative feedback to limit the current if a fuel cell becomes overheated at the higher current [FIG. 455, FIG. 456, FIG. 467].

In another embodiment, the QXR provide safe levels of charging current for an electrochemical buffer array comprising ‘n_{buf}’ series-connected cells connected in ‘m_{buf}’ parallel strings. In one exemplary case an electrochemical buffer array of cells is charged with electricity generated in the fuel cell stack and transferred through the QXR into the array at a 1 C rate for each string. For a 18650-sized Li-ion cell, each string is charged at a rate of 1 C, i.e. the current to charge the cell in one hour, being equal to I_{1C}=3 A per string. In such a case, the current limit of the QXR must be set to I_{QXR}=(I_{buf}(chg)+I_{L})≤I_{FC}(max) where for a I_{buf}(chg)=(m_{buf})(I_{1C}) so long that the fuel cell current does not exceed I_{FC}(max).

Assuming (i) the QXR current is limited to I_{QXR}≤I_{FC}(max), and (ii) the buffer charging current doesn't exceed the maximum charging current I_{buf}≤I_{buf}(max), then in such cases any decrease in load current increases the buffer charging current, and conversely any increase in load current decrease the buffer charging current. In cases where the maximum 1 C charging current is reached any further decrease in load current means the QXR current limit must be decreased proportionally whereby I_{QXR}=(I_{buf}(max)+I_{L}).

In one embodiment [FIG. 456], the QXR detects the difference between the load current demand I_{L} and the buffer charging current I_{buf} and limits the current coming from the fuel I_{FC} to ensure the buffer charging rate I_{buf}(chg) does not exceed its 1 C limit I_{1C}. For example, if m_{buf}=2 then I_{buf}(chg)≤6 A; if m_{buf}=4 then I_{buf}(chg) 12A; if m_{buf}=8 then I_{buf}(chg) 24A and so on. In this implementation, referred to as a single-output charge transfer regulator, the QXR, the buffer array, and the load are all hard wired to the summing node with no intervening device able to allocate the total QXR current between the load and the buffer.

In another embodiment [FIG. 457], referred to as a dual-output charge transfer regulator, the summing node is connected to the buffer array through a separate regulator I_{buf}(chg) m_{buf}(I_{1C}). In this circuit the device protecting the fuel cell from an overcurrent is separate and distinct from the one controlling current flow in the buffer array. As such, the value of the QXR current limit need not be changed to prevent overcharging of the buffer, whereby the fuel cell current will naturally track the load current so long that I_{QXR}≤I_{FC}(max).

During discharge, the current flowing through the electrochemical buffer reverses polarity flowing from the buffer to the load. So long that the fuel cell current doesn't exceed its maximum current I_{FC}≤I_{FC}(max) and the buffer discharge current doesn't exceed the maximum discharge rate I_{buf}(dis)≤|(m_{buf})( )| then combining the node current I_{FC}−I_{buf}=I_{L} withe I_{buf}<0, means the load current is the sum of the buffer current and fuel cell current I_{FC}+≤I_{buf}=I_{L}. Discharge of the iBFC, specified by the node current equation I_{FC}+≤I_{buf}=I_{L} is not controlled by the QXR except in the case the fuel cell current as log as I_{FC}≤I_{FC}(max). In the buffered fuel cell the protection function is performed by the aforementioned buffer-load access circuit, not the QXR. In one embodiment [FIG. 456] where the buffer series stack is hard wired to the summing node, there is no intervening device to limit the buffer discharge current. In another embodiment [FIG. 457] the charger current limiter impedes current flow to the load in which case a separate bypass known as a synchronous rectifier [FIG. 458] functions as a dead short for current flowing from the buffer cells to the load but as an open circuit during charging.

In other embodiments of the invention, a fuel cell comprised of a single layer of the inventive PFSA composite reinforced membrane with nanoparticle PTFE coating and graded gas diffusion layer made in accordance with this invention is contrasted to an inventive PFSA microporous membrane fabricated with the sacrificial filler process, also with a graded GDL as defined herein. Measured results confirm the efficiency of the PFSA-CRM graded GDL PEM+ at membrane outperforms the same area conventional Nafion® membrane and the microporous PEM+ membrane significantly outperforms both of them [FIG. 459].

Specifically at a current density of 200 mA/cm², the conversion efficiency of conventional Nafion® membranes is measured at a poor η=49%, while the PFSA-CRM reaches efficiencies of η=64%, and the microporous membrane hits η=75%. Using the techniques defined in the membrane fabrication section, the flatness of the polarization curves, i.e. the voltage sag with increasing current can be further reduced to match the same membrane's performance at lower current densities. For example, in the fabricated microporous membrane at 160 mA/cm² the measured efficiency is η=82%, increasing to η=95% at 110 mA/cm².

Using the numerous ionomeric polymer methods involving new polymers, hetero-ionomers, permanent fillers, ionic liquids, nanocoatings, and endoskeletal support, it is not unreasonable based on first principle of physics to expect the current density to double, primarily because of reducing activation losses and flattening the polarization curve by lower ohmic series resistance. For example, while a 200 cm² Nafion® membrane exhibits operating in its ohmic region exhibits an equivalent resistance of 2.4Ω, the PFSA-CRM PEM+ has an equivalent resistance of 1.7Ω, with the microporous membrane between 1.2Ω and 1.0Ω.

In another embodiment of this invention, the microporous membrane is assembled into a μstack of twelve layers of microporous PFSA with endoskeletal support, each comprising 200 cm² of active area. The inventive design comprises the non-obvious combination of numerous inventive embodiments, delivering unique advantages unrivaled by all other PEM fuel cells, whether commercial or still in research. Specifically, the inventive fuel cell features include
the μstack delivers a minimum of 40 A at 8.2V with only 82 W of self heating where conventional films dissipate 160 W or greater under the same conditions;
the μstack delivers 333 W at 75% efficiency where Nafion® is only able to deliver 155 W at 50% efficiency;
the series electrical resistance internal to one μstack is 60 mΩ compared to a conventional fuel cell with hundreds of ohms adversely impacting transient performance;
because of its low profile height and commensurately high thermal conductivity, the inventive μstack runs significantly cooler than conventional fuel cells, representing an improvement in thermal conductivity by at least a factor of 3× to 8× depending of the fuel cell stack height. This thermal advantage enables the μstack to deliver higher power per layer without requiring the need for forced fluid cooling within the fuel cell using TPPs;
three low-profile μstacks connected in series deliver 1 kW in less than 650 cm² area and with a height lower in profile than an 18650 lithium ion battery; and where
a fuel cell can be constructed of 3, 4, or 5 μstacks able to operate to humidity levels as low as 27% depending on dynamic operation of the fuel cell.

In another set of embodiments, an intelligent buffered fuel cell is assembled into a modular power system referred to as a grid-power energy bank [FIG. 403] comprising one-to-twenty 5 kW modules named ‘power blades’ combined with a chassis, rack or card-cage with slots matching edge connectors on the power blades. The power blades comprise a multifunction temperature regulated backplate and attached printed circuit board to which the iBFC components are physically mounted, electrically connected, and thermally cooled. The iBFC power blade may include a separate enclosure or be assembled open frame.

The μstack fuel cells and buffer cells are thereby mounted on the backplate by soldering or gluing onto its single layer or multilayer PCB laminate. In one embodiment the PCB comprises a single layer of thick conductors affixed to only one side of the multi-function backplate. In another embodiment, the buffer cells comprise and array of 18650 cylinder shaped Li-ion batteries mounted perpendicularly to the PCBs surface [FIG. 463].

By inserting a power blade into the slot, the scalable energy bank provides electrical, gas, and cooling connectivity between the energy bank frame and the power blade, including pressurized hydrogen or methanol fuel plumbed to the FC anodes in every μstack fuel cell, recycling of unused hydrogen, pressurized oxygen or forced air plumbed to the FC cathodes, recycling of effluent air with humidity control and excess water removal from cathode effluent; and cooling and temperature regulation via piped refrigerant, coolant, water, or air.

In one embodiment the cooling channel includes a cooling coil [FIG. 470] located within the power blade's backplate support carrying coolant or forced fluids to remove waste heat from the μstacks and maintain a target operating temperature throughout the backplate even while each mounted μstack conducts heat into the backplate to prevent thermal damage to the fuel cell. To minimize thermal resistance, the μstacks are mounted directly onto metallic conductors formed atop or with the backplate [FIG. 464, FIG. 465, FIG. 468B].

In addition the inventive quasi constant temperature backplate for conductive cooling, the cooling system may also include forced air cooling, or fluidic cooling within the fuel cell conducted through dedicated cooling channels with tripolar plates forming the fuel cell μstack. In another embodiment, the entire chassis is enclosed and air conditioned to maintain a room temperature ambient. In another embodiment, the chassis includes a ventilation system to vent any leaking hydrogen gas of the chassis enclosing the power bank and to outside any building. In one embodiment a hydrogen gas detector activates forced gas removal from the enclosure when a detectable level of hydrogen is sensed.

In one set of embodiments oxygen and hydrogen gasses, and optionally refrigerant are delivered in a tubeless distribution system via gas conduits in the backplate [FIG. 464] where the attachment of the μstacks onto the backplate includes (i) gas channels functioning as conduits within the backplate to deliver gas to specific gas ports; (ii) openings in the PCB called vias [FIG. 465, FIG. 468A, FIG. 468B] enabling gas flow between the gas port and the ingress and egress pipe nipples located on the underside of the μstack fuel cell assembly; (iii) and gaskets or grommets surrounding the gas port [FIG. 465, FIG. 467, FIG. 468B] to prevent air, gas, or fluid leakage from the gas port interface; and (iv) mounting the fuel cell μstack onto the conductive traces of copper or other metal using solder or conductive epoxy to facilitate a lower resistance electrical connection whereby the conductors may be coplanar with the top of the PCB insulator layer or sit atop it [FIG. 465]. In another embodiment, a process for forming the gas conduits in the backplate involves etching the backplate [FIG. 46B] then attaching or laminating the PCB onto it [FIG. 466D]. The copper conductive traces can then be attached by lamination [FIG. 466E] or deposited. In an alternative embodiment, the PCB is preformed with embedded coplanar thick power conductors [FIG. 468A] and optionally a second thinner conductive layer for finer linewidth connectivity to integrated circuits.

A variety of iBFCs able to deliver a minimum of 5 kW of power-on-demand and made in accordance with this invention are assembled onto a standardized size power blade by varying the area ratio of fuel cell μstacks to buffer cells. In one embodiment a power blade dominated by twelve fuel cells with only 96 buffer cells [FIG. 472A] provides 4 kW of continuous power and 5 kW of power on demand [FIG. 473D]. In an alternative battery heavy embodiment, a power blade comprising only three fuel cell μstacks and 480 buffer cells [FIG. 472H] delivers only 1 kW of continuous power but kW of power on demand. Intermediate designs include a minimally configured power blade capable of 1 kW continuous power and 5.2 kW of PoD [FIG. 472I] and the versatile five μstack design [FIG. 472F] comprising 280 cells able to supply 5.2 kW of power on demand [FIG. 473C] but still deliver 1.7 kW of continuous power or 40 kW per day thereby meeting the minimum daily need of 33 kWh as can the four μstack 296 cell 5 kW design [FIG. 472G].

### BRIEF DESCRIPTION OF THE DRAWINGS

FIG. 1. Mechanistic schematic of hydrogen fuel cell electrochemistry.

FIG. 2. Pseudo-structural model and chemical formula for PFSA.

FIG. 3. Conduction mechanisms in ion exchange membranes.

FIG. 4A. Comparison of chemical formulas for commercial PFSA ionomers and PTFE.

FIG. 4B. Generalized and schematic representations of PFSA ionomer, pendant, and backbone

FIG. 5. Grafting of PFSA sidechains onto PTFE backbone.

FIG. 6. Charge transport models for alkali, MCFC, PAFC, and SOFC fuel cells showing ion conduction in electrolyte.

FIG. 7. Diagram of fuel cell components comprising a membrane electrode assembly (MEA).

FIG. 8A. Lumped element schematic representation of a fuel cell.

FIG. 8B. Simplified lumped element schematic representation of a fuel cell.

FIG. 9A. Schematic of operation of fuel cell membrane electrode assembly depicting mechanisms involving water.

FIG. 9B. Schematic representation of function of gas diffusion layer (GDL) in a PEM fuel cell.

FIG. 10. Exemplary curves of conventional PEM hydrogen fuel cell voltage V_{FC} at 70° C. as a function of current density I/A for various levels of relative humidity RH.

FIG. 11. Exemplary curves of conventional PEM hydrogen fuel cell voltage V_{FC} at 90° C. as a function of current density I/A for various levels of relative humidity RH.

FIG. 12. Exemplary curves of conventional PEM hydrogen fuel cell voltage V_{FC} at 70° C. as a function of relative humidity RH for various levels of current density I/A.

FIG. 13. Exemplary curves of conventional PEM hydrogen fuel cell specific resistance R_{FC} A at 70° C. as a function of current density I/A for various levels of relative humidity RH.

FIG. 14. Current dependence of voltage for a 4s1p fuel cell stack including resistance calculations.

FIG. 15A. Electrical resistance as a function of ion exchange membrane thickness.

FIG. 15B. Graph representing the cross sectional vertical displacement, i.e. sag, of a polymeric membrane as a function of width and film thickness.

FIG. 16. Graph illustrating endoskeleton reduces membrane sag.

FIG. 17. Illustration of membrane swelling with and without endoskeletal support.

FIG. 18A. Top view of membrane frame.

FIG. 18B. Top view of membrane frame including exoskeleton and membrane matrix.

FIG. 18C. Top view of membrane matrix after frame removal.

FIG. 19A. Process flow options for fabricating an MEA3 ion exchange membrane.

FIG. 19B. Process flow options for fabricating an MEA5 ion exchange membrane from a MEA3 CCM.

FIG. 20. Cross sectional comparison of membrane matrix with symmetric and offset frames.

FIG. 21. Cross section of mold forming membrane matrix frame and skeleton.

FIG. 22. Cross section of mold forming fiber reinforced membrane matrix frame and skeleton.

FIG. 23. Cross section of ion exchange membrane comparing bulk and surface ionomer conduction.

FIG. 24. Top view of membrane matrix before and after IEM singulation.

FIG. 25. Top view of membrane matrix illustrating frame cut lines.

FIG. 26. Top view of membrane matrix illustrating IEM cut lines.

FIG. 27. Top and side view of membrane matrix with offset frame.

FIG. 28. Side views of membrane matrix with offset frame with and without tie bar.

FIG. 29. Side view of empty mold chamber for IEM fabrication.

FIG. 30. Side view of mold chamber with mold chase for fabricating IEM membrane matrix with offset frame.

FIG. 31. Side view of mold chamber with mold chase for offset frame and skeleton fabrication loaded with mold compound.

FIG. 32. Side view of mold chamber with mold chase for offset frame and skeleton fabrication after polymerization.

FIG. 33. Side view of inverted of membrane frame and skeleton in empty mold chamber.

FIG. 34. Side view of step loading of ionomer into mold chamber with inverted frame and skeleton.

FIG. 35. Side view of step applying mold cap to ionomer loaded mold.

FIG. 36. Side view of step pressurizing ionomer loaded mold during polymerization.

FIG. 37. Side view of step for heat treatment during ionomer polymerization.

FIG. 38. Side view of anode catalyst coating of membrane.

FIG. 39. Cross section of fabricated catalyst coated membrane and matrix frame.

FIG. 40. Side view of step attaching handle to CCM and matrix frame.

FIG. 41. Side view of membrane during cathode catalyst coating.

FIG. 42. Cross section of cathode catalyst coated membrane including handle.

FIG. 43. Cross section of cathode catalyst coated of membrane with handle not shown.

FIG. 44. Side view of step attaching cathode GDL to CCM and matrix frame.

FIG. 45. Cross section of CCM with cathode GDL and matrix frame.

FIG. 46. Side view of step attaching anode GDL to CCM and matrix frame.

FIG. 47. Side view of step during laser singulation of MEA5 IEM.

FIG. 48. Cross section of singulated MEA5 five-layer IEM.

FIG. 49. Cross section of fabricated MEA7 seven-layer IEM.

FIG. 50. Top and side views of matrix frame and skeleton.

FIG. 51. Top and side views of matrix frame and skeleton and ionomeric membrane.

FIG. 52. Top and side views of matrix frame and skeleton comprising multiple CCM three layer MEA3s.

FIG. 53. Top and side views of matrix frame and skeleton comprising multiple five layer MEA5s.

FIG. 54. Top and side views of matrix frame and skeleton comprising multiple five layer MEA5s illustrating singulation laser cut pattern.

FIG. 55. Top vide and cross section of singulated MEA5 five-layer IEM.

FIG. 56. Top and side view of membrane matrix with vertically symmetric frame.

FIG. 57. Cross sections of membrane matrix with symmetric frame with and without tie bar.

FIG. 58. Side view of mold chamber with multi-piece mold chase.

FIG. 59. Side view of multi-piece mold chase after polymerization of matrix frame.

FIG. 60. Side view of multi-piece mold chase after removal of top chase.

FIG. 61. Side view of multi-piece mold chase after polymerization of skeleton.

FIG. 62. Side view of multi-piece mold chase after removal of intermediate mold chase and loading of ionomeric monomers.

FIG. 63. Side view of step pressurizing ionomer loaded mold during polymerization.

FIG. 64. Side view of step for heat treatment during ionomer polymerization.

FIG. 65. Side view of step for heat treatment after ionomer polymerization.

FIG. 66. Side view of step attaching handle to membrane and matrix frame.

FIG. 67. Cross section of membrane with attached handle prior to catalyst deposition.

FIG. 68. Side view of anode catalyst coating of membrane.

FIG. 69. Cross section of anode catalyst coated membrane and matrix frame.

FIG. 70. Cross section of membrane during cathode catalyst deposition after handle has been removed from anode and attached to cathode side.

FIG. 71. Side view of fabricated CCM after cathode catalyst coating.

FIG. 72. Side view of steps attaching cathode and anode GDL to CCM and matrix frame after handle removal.

FIG. 73. Cross section of matrix of MEA5 five-layer IEMs prior to singulation and frame removal.

FIG. 74. Cross section of matrix of MEA5 five-layer IEMs illustrating laser cut lines.

FIG. 75. Cross section of singulated five-layer IEM5.

FIG. 76. Cross section of singulated seven-layer IEM7.

FIG. 77A. Process flow for fabrication of CRM comprising PFSA-PVA-PTFE ionomer.

FIG. 77B. Process flows for fabrication of various exemplary porous membrane IEMs.

FIG. 78. Photomicrographs and SEMs of IEM fabricated films.

FIG. 79A. Voltage-current characteristics, aka polarization curves of various CRM films contrasted to Nafion® membrane performance.

FIG. 79B. Power output curves for various thickness CRM membranes versus Nafion® membrane performance.

FIG. 80. Lumped element model of fuel cell showing resistive and polarization losses.

FIG. 81. Process flows for fabrication of various porous IEM membranes.

FIG. 82. Photos of exemplary steps in porous PFSA IEM membrane fabrication.

FIG. 83. Photo of porous exchange membrane.

FIG. 84. Top view and cross sections of porous exchange membrane.

FIG. 85A. Voltage-current characteristics, aka polarization curves contrasting porous PEM, CRM PEM, and Nafion® membrane performance.

FIG. 85B. Voltage-current “polarization” characteristics of measured porous PEM, CRM PEM, and Nafion® membrane performance identifying DC parametric data points.

FIG. 85C. Piecewise linear model of measure PEM voltage-current characteristics, of porous PEM, CRM PEM, and Nafion® membrane performance identifying DC parametric data points.

FIG. 85D. Power output density and power efficiency as a function of power input density comparing porous PEM, CRM PEM, and Nafion® membrane performance.

FIG. 85E. Power loss and power loss density as a function of power input and power input density comparing porous PEM, CRM PEM, and Nafion® membrane performance.

FIG. 85F. Power loss and power loss density as a function of power output and power output density comparing porous PEM, CRM PEM, and Nafion® membrane performance.

FIG. 86. Power output as a function of current density comparing porous PEM, CRM PEM, and Nafion® membrane performance.

FIG. 87A. Cross sectional depiction of a homogenous GDL gas diffusion layer and CCM.

FIG. 87B. Cross sectional depiction of a bilayer gas diffusion layer comprising a uniform GDL with MPL microporous layer atop CCM.

FIG. 88. Cross sectional comparison of fuel cell hydration with and without MPL.

FIG. 89. Photomicrographs of BPP gas channel at various FC screw pressures showing varying degrees of GDL encroachment.

FIG. 90A. Schematic representation of three-head GDL printer with varying inks of carbon fiber length.

FIG. 90B. Schematic representation of single-head GDL printer with carbon ink comprising varying a blended mix of carbon fiber lengths.

FIG. 91. Schematic representation of hGDL heterogenous gas diffusion layer comprising three layer graded GDL with MPL.

FIG. 92. Schematic representation of hGDL heterogenous gas diffusion layer and CCM illustrating SEMs of three layer graded GDL with MPL.

FIG. 93. Cross section of MEA7 assembly comprising hGDL with graded porosity.

FIG. 94. Depiction of hGDL attachment to CCM with and without decal laminated catalyst layer of MPL.

FIG. 95. Process flow for MEA5 fabrication forming and attaching decal laminated catalyst layer on MPL to sputter coated CCM.

FIG. 96A. Voltage-current characteristics, aka polarization curves contrasting porous PEM, CRM PEM, and Nafion® membrane performance with and without hGDL.

FIG. 96B. Voltage-current characteristics of measured porous PEM, CRM PEM, and Nafion® membrane performance with and without hGDL identifying DC parametric data points.

FIG. 96C. Piecewise linear model of measure PEM voltage-current characteristics, of porous PEM, CRM PEM, and Nafion® membrane performance with and without hGDL identifying DC parametric data points.

FIG. 96D. Power output density as a function of power input density comparing porous PEM, CRM PEM, and Nafion® membrane performance with and without hGDL.

FIG. 96E. Power efficiency as a function of power input density comparing porous PEM, CRM PEM, and Nafion® membrane performance with and without hGDL.

FIG. 96F. Power loss and power loss density as a function of power input and power input density comparing porous PEM, CRM PEM, and Nafion® membrane performance with and without hGDL.

FIG. 96G. Power loss and power loss density as a function of power output and power output density comparing porous PEM, CRM PEM, and Nafion® membrane performance with and without hGDL.

FIG. 97. Power output as a function of current density comparing porous PEM, CRM PEM, and Nafion® membrane performance with and without hGDL.

FIG. 98. Top view of exemplary assembled stack of MEA7 IEMs highlighting layer thicknesses.

FIG. 99. Cross sectional comparison of 24V conventional and advanced fuel cells contrasted to lithium ion cell and 4V AFC dimensions.

FIG. 100. Cross section of seven-layer MEA7 fuel cell assembly depicting TPP tripolar plate with internal temperature sensor.

FIG. 101. Functional diagram of temperature sensing, feedback, and control of iBFC via a heat exchange and open cathode airflow.

FIG. 102A. Relationship between fuel cell peak temperature and thermal resistance versus air flow rate for 48 W power dissipation.

FIG. 102B. Exemplary data points relating fuel cell peak temperature and thermal resistance versus air flow rate.

FIG. 103. Graph of power loss versus power output of Nafion® PEM, CRM PEM+, and porous PEM+fuel cells highlighting air cooling limit.

FIG. 104. Simplified cross sectional schematic representation comparing (a) a IEM carbon polymer matrix backbones, (b) the carbon polymer matrix including fluorine bonds and resulting electrostatic cloud, and (c) carbon polymer matrix and electrostatic cloud modified by sacrificial filler (after removal).

FIG. 105. Molecular model of pendant graft depicting (a) pristine polymer, (b) fluorocarbon backbone with exposed carbon graft point, and (c) sidechain pendant grafting ionomer to graft point of carbon backbone.

FIG. 106. Schematic representing nanoparticle coated hydrophobic fluorocarbon backbone depicting amorphous glassy matrix comprising (a) pristine inert polymer, (b) matrix after nanoparticle spray coating, and (c) ionomer attachment after annealing.

FIG. 107. Summary of exemplary inventive elements in fabricated ion exchange membrane including support skeleton, PFSA-PTFE ionomeric membrane, pillar link bridging membrane to endoskeleton, pores created by sacrificial fillers, and nanocoating.

FIG. 108. Modified fluorocarbon backbone contrasting m repeated chains of PFMMD and PDD.

FIG. 109. Process flow for amorphous glassy matrix membrane formation including starting materials PDDₘ and PSVE, polymerization, and subsequent hydrolysis.

FIG. 110. Summary of exemplary inventive elements in fabricated ion exchange membrane including support skeleton, sulfonated fluorocarbon glass (SFG) ionomeric membrane, pillar link bridging membrane to endoskeleton, and pores created by sacrificial fillers.

FIG. 111. Process flow for converting styrene monomers into a polymer.

FIG. 112. Process flow for fabricating a polymer membrane by grafting a bromated hydrocarbon onto a polyolefin polyethylene backbone.

FIG. 113. Summary of exemplary inventive elements in fabricated ion exchange membrane including support skeleton, sulfonated or bromated polyethylene (SPE, BrPE) ionomeric membrane, pillar link bridging membrane to endoskeleton, and pores created by sacrificial fillers.

FIG. 114. Process flow for synthesis of a polymer membrane based on combining phosphorylated polyvinyl alcohol (PVA), phosphorylated cellulose acetate (CA), and glutaraldehyde (GA) to form the polymeric ionomer PVA-CA.

FIG. 115. Summary of exemplary inventive elements in fabricated ion exchange membrane including support skeleton, functionalized polyvinyl alcohol ionomeric membrane (CA-PVA, SPVA), pillar link bridging membrane to endoskeleton, and pores created by sacrificial fillers. Ionomer may comprise cellulose acetate (CA) or sulfonic acid (not shown).

FIG. 116. Process flow for synthesis of a polymer membrane based on sulfosuccinic acid (SSA) treated polyvinyl alcohol (PVA) to form the polymeric ionomer PVA-SSA.

FIG. 117. Summary of exemplary inventive elements in fabricated ion exchange membrane including support skeleton, cross-linked sulfonated polyvinyl alcohol (sPVA) ionomeric membrane, pillar link bridging membrane to endoskeleton, and pores created by sacrificial fillers. As shown, sulfonic acid acts as SSA co-polymer cross linker.

FIG. 118. Process flow for synthesis of a polymer membrane based on combining polyvinylidene fluoride (PVDF), polyvinyl pyrrolidone (PVP), and polystyrene sulfonic acid (PSSA) to form the polymeric ionomer PVDF-PVP-PSSA.

FIG. 119. Exemplary polymers able to bond with polyvinylidene fluoride (PVDF) in forming ionomeric polymers comprising polyvinyl alcohol (PVA), poly (methyl methacrylate) (PMMA), polycarbonate (PC), and perfluorosulfonic acid (PFSA), or combinations thereof.

FIG. 120. Process flow for synthesis of a polymer membrane based on combining polyvinylidene fluoride (PVDF), polyvinyl pyrrolidone (PVP), and sulfamic acid (SA) to form the polymeric ionomer PVDF-PVP-SA.

FIG. 121. Process flow for synthesis of a polymer membrane by converting polyvinylidene fluoride (PVDF) into dehydrofluorinated polyvinylidene fluoride (D-PVDF) then combined with 3-sulfopropyl acrylate (SPA) and azobisisobutyronitrile (AIBN) to form PVDF-AIBN-SPA.

FIG. 122. Process flow for synthesis of a polymer membrane by combining dehydrofluorinated polyvinylidene fluoride (D-PVDF) with 1H, 1H, 2H-perfluoro-1-hexene (PFH), 3-sulfopropyl acrylate (SPA), and azobisisobutyronitrile (AIBN) to form PVDF-AIBN-SPA-PFH.

FIG. 123. Process flow for synthesis of a polymer membrane by combining polyvinylidene fluoride (PVDF) and hexafluoropropylene (HFP) with diisopropyl peroxidicarbonate (DIPPDC) and 1,1,2-trichlorotrifluoroethane (R-113) to produce polymer PVDF-HFP subsequently sulfonated by treatment in CI-SO₃H and HCl.

FIG. 124. Summary of exemplary inventive elements in fabricated ion exchange membrane including support skeleton, sulfonated polyvinylidene fluoride (PVDF) ionomeric membrane, pillar link bridging membrane to endoskeleton, and pores created by sacrificial fillers. PVDF may comprise a variety of polymer isomers, copolymers, and variants including PVP-PSSA, PMMA, PC, PFSA. PVP-SA, AIBN-SA, AIBN-SPA, AIBN-SPA-PFH, and/or HFP.

FIG. 125. Composition of a membrane comprising a copolymer blend of the polyolefin polypropylene and perfluorosulfonic acid.

FIG. 126. Summary of exemplary inventive elements in fabricated ion exchange membrane including support skeleton, copolymer blend of polypropylene (PP) and perfluorosulfonic acid (PFSA) ionomeric membrane, pillar link bridging membrane to endoskeleton, and pores created by sacrificial fillers.

FIG. 127. Process flow for synthesis of a polymer membrane by combining polyvinyl chloride (PVC) and ethylenediamine (EDA), then treating the polymer with sulfuric acid H₂SO₄ to produce sulfonated PVC.

FIG. 128. Summary of exemplary inventive elements in fabricated ion exchange membrane including support skeleton, sulfonated polyvinyl chloride (sPVC) ionomeric membrane, pillar link bridging membrane to endoskeleton, and pores created by sacrificial fillers.

FIG. 129. Process flow for synthesis of a heterogenous polymer membrane by combining 2,2′-bis[4-(4-aminophenoxy) phenyl] propane (BAPP) with 4,4′-diaminodiphenyl ether-2,2′-disulfonic acid (ODADS) and 4,4′-bisphenol A dianhydride (BPADA) to produce sulfonated polyamide (sPI).

FIG. 130. Process flow for synthesis of a heterogenous polymer membrane by combining an aromatic sulfonamide such as sulfonated 1,4-bis(4-aminophenoxy)benzene (pBABTS) with diamine and dianhydride to produce sulfonated polyamide (PI).

FIG. 131. Exemplary molecules for polyimide based polymer membrane synthesis including sulfonamides, diamines, and dianhydrides.

FIG. 132. Summary of exemplary inventive elements in fabricated ion exchange membrane including support skeleton, sulfonated polyimide (sPI) ionomeric membrane, pillar link bridging membrane to endoskeleton, and pores created by sacrificial fillers.

FIG. 133A. Comparison of homopolymer, linear copolymer, and angled linear copolymer molecules.

FIG. 133B. Comparison of cross-linked polymers with copolymer and ligand links.

FIG. 133C. Comparison of cross-link loop and ionomer-link loop homopolymers, and ionomer-link multi-chain copolymers

FIG. 134. Process flow for fabricating sulfonated heteropolymer polystyrene involving (a) conventional method, (b) high mole-fraction sulfonic acid synthesis.

FIG. 135A. Process flow for fabricating sulfonated heteropolymer polystyrene involving (a) n-butyl styrenesulfonate monomer, (b) styrenesulfonate sSA homopolymer.

FIG. 135B. Process flow for fabricating sulfonated heteropolymer polystyrene involving (c) cross linking of styrenesulfonate CL-sSA polymer.

FIG. 136. Summary of exemplary inventive elements in fabricated ion exchange membrane including support skeleton, sulfonated polystyrene (sPS) ionomeric membrane, pillar link bridging membrane to endoskeleton, and pores created by sacrificial fillers.

FIG. 137. Chemical structure of heteropolymer polymer comprising sulfonated poly (fluorenyl ether ketone nitrile).

FIG. 138. Summary of exemplary inventive elements in fabricated ion exchange membrane including support skeleton, sulfonated poly (fluorenyl ether ketone nitrile) ionomeric membrane, pillar link bridging membrane to endoskeleton, and pores created by sacrificial fillers.

FIG. 139. Chemical structures of heteropolymer polymer precursors including poly(p-phenylene 2,5-disulfonic acid) (PPDSA), poly(p-biphenylene 3,3′-disulfonic acid) (PBPDSA), sulfonated sidechain polyphenylene (sPP), and poly[(p-biphenylene 3,3′-disulfonic acid)-co-(p-phenylene 2,5-disulfonic acid)](BXPY).

FIG. 140. Process flow for fabricating sulfonated polyphenylene heteropolymers comprising (a) poly(benzoyl-1,4-phenylene, and (b) poly(p-phenoxybenzoyl-1,4-phenylene).

FIG. 141. Process flow for fabricating sulfonated polyphenylene heteropolymer SPP-QP comprising SP and QP monomers.

FIG. 142. Sulfophenylated polyphenylene (sPPP) comprising a generic heteropolymer comprising radicals sPPP-H⁺, sPPN-H⁺, and sPPB-H⁺.

FIG. 143. Sulfophenylated polyphenylene (sPPP) heteropolymer radicals sPPT-H⁺ and sPPBm-H⁺.

FIG. 144. Sulfophenylated polyphenylene (sPPP) heteropolymer radicals sPPP N-free, sPPP (1+0)N, sPPP (1+1)N, sPPP (3+0)N, and sPPP (3+3)N.

FIG. 145. Chemical structures of heteropolymer sulfophenylated polyphenylene containing sterically hindered pyridines.

FIG. 146. Process flow to modify phenylated polyphenylene (PPP) heteropolymer into sulfonated Diels-Alder polyphenylene SDAPP.

FIG. 147. Process flow for synthesis of a sulfonated phenylated polyphenylene sPPP-H⁺ from a pre-functionalized diene monomer tetra(para-sulfonated) triethylammonium bistetracyclone salt (TEAsBTC).

FIG. 148. Process flow for synthesis for hydroxylation of sulfonated phenylated polyphenylene sPPP-H⁺ into hydroxylated sulfonated phenylated polyphenylene sPPP-OH.

FIG. 149. Processes for (a) diazotization of 4,4′-diamino-2,2′-biphenyldisulfonic acid (DiBPS) into 4,4′-diiodo-2,2′-biphenyldisulfonic acid (DilPS), and (b) halogenation of 4,4′dibromobiphenyl (DBrPh) into 4,4′dibromo-3,3′biphenyldisulfonic acid (DiBrBS).

FIG. 150. Variations in radical R group for (a) 4,4′-diiodo-2,2′-biphenyldisulfonic acid (DilPS) and (b) 4,4′dibromo-3,3′biphenyldisulfonic acid (DiBrBS).

FIG. 151. Exemplary variations in sulfonated polyphenylene sidechains.

FIG. 152. Process for synthesis of sulfonimide branched poly(phenylenebenzophenone)s (Si-branched PPBP) polymers.

FIG. 153. Summary of exemplary inventive elements in fabricated ion exchange membrane including support skeleton, sulfonated polyphenylene branched ionomeric membrane, pillar link bridging membrane to endoskeleton, and pores created by sacrificial fillers. The sulfonated polyphenylene (sPP) family of polymers may comprise an ionomer of reactive sulfonic acid groups —SO₃H including variants sP, sPP, PPDSA, sPP-QP, sPPP-H⁺, sPPN-H⁺, sPPB-H⁺, sPPT-H⁺, sPPBm-H⁺, sPPBo-H⁺, sPPP-OH, sPPP N-free, sPPP (X+0)N, sPPP (X+1)N, BXPY, sPPP, DiBPS, DiPS, DiBrBS, and Si-PPBP.

FIG. 154. Process flow for synthesis of the heteropolymer polyarylene ether (SPAE) from 4,4′-(9-fluorenylidene) diphenol (BPFL), decafluorobiphenyl (DFBP), 4,4′(hexafluoroisopropylidene) diphenol (BPHF).

FIG. 155. Process flow for synthesis of the heteropolymer sulfonated polyarylene ether (SPAES) from 4,40-difluorodiphenyl (DFDPS); 4,4-dihydroxybiphenyl (BP); and 3,30-Disulfonated-4,40-difluorodiphenyl sulfone (SDFDPS).

FIG. 156 Process flow for synthesis of the heteropolymer sulfonated polyarylene ether (SPAES) perfluoropolyether grafted graphene oxide (PFPE-GO) from graphene oxide (GO) and fluorinated surfactant Krytox® 157 FSL.

FIG. 157. Chemical structural depiction of exemplary heteropolymer sulfonated polyarylene ether (SPAE) incorporating phosphotungstic acid (PWA) and graphene oxide (GO).

FIG. 158. Molecular structure exemplary heteropolymer polyarylene ether sulfone (SPAEA) including sulfonated radical ionomer variants.

FIG. 159. Summary of exemplary inventive elements in fabricated ion exchange membrane including support skeleton, polyarylene ether (SPAE) including sulfonated radical variants ionomeric membrane, pillar link bridging membrane to endoskeleton, and pores created by sacrificial fillers. Polymer may embed perfluoropolyether grafted graphene oxide (PFPE-GO) as permanent filler.

FIG. 160. Process flow forming an unfunctionalized polymer poly ether-ether ketone (PEEK).

FIG. 161. Exemplary process to functionalize insulative poly ether-ether ketone (PEEK) into ionomeric polymer sulfonated poly ether-ether ketone (sPEK).

FIG. 162. Examples of various functionalized ether ketone polymers, specifically sulfonated poly ether ketone (sPEK), sulfonated poly ether-ether ketone (sPEEK), and sulfonated poly ether ketone-ketone (sPEKK).

FIG. 163. Further examples of various functionalized ether ketone polymers, specifically sulfonated poly ether-ether-ether ketone (sPEEEK), sulfonated poly ether-ether ketone-ketone (sPEEKK), sulfonated poly ether ketone-ketone-ketone (sPEKKK).

FIG. 164. A further example of a functionalized ether ketone polymer, specifically sulfonated poly ether ketone ether ketone-ketone (sPEKEKK).

FIG. 165. An exemplary process to synthesize a functionalized ionomeric polymer comprising sulfonated poly ether ketone (sPEK).

FIG. 166. An exemplary process to synthesize a linear copolymer of sulfonated poly ether ketone bonded to a non-functionalized poly ether ketone chain (sPEK-co-PEK, aka 2PEK).

FIG. 167. An exemplary process to synthesize a functionalized ionomeric polymer comprising sulfonated poly ether-ether ketone (sPEEK).

FIG. 168. An alternative process to synthesize a functionalized ionomeric polymer comprising sulfonated poly ether-ether ketone (sPEEK).

FIG. 169. Another process to synthesize a functionalized ionomeric polymer comprising sulfonated poly ether-ether ketone (sPEEK).

FIG. 170. Summary of exemplary inventive elements in fabricated ion exchange membrane including support skeleton, a poly ether ketone (PEK) and poly ether-ether ketone (PEEK) based polymers and variants thereof including sulfonated functional groups, ionomeric membranes, pillar links bridging membrane to endoskeleton, and pores created by sacrificial fillers.

FIG. 171. An exemplary process to synthesize an insulative polymer comprising poly ether-ether sulfone (PEESf).

FIG. 172. Exemplary process to functionalize insulative poly ether-ether sulfone (PEESf) into ionomeric polymer sulfonated poly ether-ether sulfone (sPEESf).

FIG. 173. An exemplary process to synthesize an ionomeric polymer comprising sulfonated poly ether sulfone (sPESf).

FIG. 174. Exemplary copolymer of sulfonated poly ether-ether sulfone (sPEES) cross linked via sulfonic acid to poly(ether imide) (PEI) chain.

FIG. 175A. Exemplary processes to synthesize poly ether sulfones by self-polycondensation of monomers.

FIG. 175B. Exemplary processes for sulfonating polyether sulfones.

FIGS. 176A-176B. An exemplary process for converting sulfonated poly ether-ether sulfone (sPEES) into sulfonated poly(1,4-phenylene ether-ether-sulfone)-poly(2-acrylamido-2-methyl-1-propanesulfonic acid) (sP(PhEESf)-PAMPS).

FIG. 177A An exemplary process to synthesize an insulating polymer comprising bis-hydroxyphenyl ether sulfone (BH-PEDSf) functionalized into sulfonated polyether di-sulfone (sPEDSf).

FIG. 177B. An exemplary process to synthesize an insulating polymer comprising bis-hydroxyphenyl ether sulfone (BH-PEDSf) functionalized into sulfonated polyether di-sulfone (sPEDSf).

FIG. 178. An exemplary process to synthesize an ionomeric polymer comprising sulfonated fluorinated polyethersulfone (sFPESf).

FIG. 179. Exemplary process for synthesizing sulfonated poly(ether sulfone) sP(PhESf) from a hydroxy-quaterphenol aromatic diol containing four phenyl substituents at the 2, 2′, 6, and 6′ positions of 4,4′-diphenyl ether.

FIG. 180. Summary of exemplary inventive elements in fabricated ion exchange membrane including support skeleton, a poly ether sulfone (PEES) based polymer and variants thereof including sulfonated functional groups, ionomeric membrane, pillar link bridging membrane to endoskeleton, and pores created by sacrificial fillers. Variants include ionomer cross linked copolymers comprising SPEES and poly(ether imide) (PEI).

FIG. 181A. An exemplary process to synthesize an insulative polymer comprising poly ketone-ketone sulfone (PKKSf) functionalized into sulfonated polyketone ketone sulfone (sPKKSf).

FIG. 181B. An exemplary process to synthesize an insulative polymer comprising poly ketone-ketone sulfone (PKKSf) functionalized into sulfonated polyketone ketone sulfone (sPKKSf).

FIG. 182A. An exemplary process to synthesize an insulating polymer comprising poly (arylene ketone ether ketone sulfone) (PAKEKSf) as a precursor to its sulfonated derivative sulfonated poly (arylene ketone ether ketone sulfone) sPAKEKSf.

FIG. 182B. An exemplary process to synthesize an insulating polymer comprising poly (arylene ketone ether ketone sulfone) (PAKEKSf) as a precursor to its sulfonated derivative sulfonated poly (arylene ketone ether ketone sulfone) sPAKEKSf.

FIG. 183A. An exemplary process to synthesize an ionomeric polymer comprising sulfonated di-poly (arylene ketone ether sulfone) (s2PAKESf).

FIG. 183B. An exemplary process to synthesize an ionomeric polymer comprising sulfonated di-poly (arylene ketone ether sulfone) (s2PAKESf).

FIG. 184. Exemplary process to synthesize sulfonated poly (arylene ether ketone sulfone) (sPAEKSf) from phenyl, benzene, ether, and sulfone compounds.

FIG. 185A. Exemplary processes to synthesize bismuth trimesic acid (BiTMA) and bismuth molybdate (Bi₂MoO₆) as conductive and catalytic fillers for ion exchange membranes.

FIG. 185B. Exemplary process for functionalizing sulfonated poly ether sulfone (sPESf) to form heteropolymers comprising sulfonated poly(ether sulfone)-(bismuth trimesic acid) (sPESf-BiTMA) and poly(sulfonated ether sulfone)-(bismuth molybdate) (SPESf-Bi₂MoO₆).

FIG. 186. Summary of exemplary inventive elements in fabricated ion exchange membrane including support skeleton; poly ketone sulfone (PKS), poly ether sulfone (PES), and poly ketone-ether sulfones (PKES) based polymers and variants thereof; including sulfonated functional groups, ionomeric membrane, pillar link bridging membrane to endoskeleton, and pores created by sacrificial fillers. Permanent fillers include bismuth trimesic acid (SPES-BiTMA) and bismuth molybdate (SPES-Bi₂MoO₆).

FIG. 187. Structural representations of single-wall and multi-wall carbon nanotubes (SW and MW CNTs) FIG. 188. Exemplary process for functionalization of carbon nanotubes using sonication.

FIG. 189. Exemplary process for functionalization of carbon nanotubes by grafting of carboxylic acid salt.

FIG. 190. Illustrative process for synthesis of proton exchange membranes comprising various polymers including PFSA, PFSA-PTFE, SPAES, SPEEK, PVA, PBI and CS; doped with catalyst and ionomer functionalized carbon nanotubes including SO₃H, COOH, POH, —NH₂, SiO₂, and TiO₂.

FIG. 191. Exemplary process for forming perfluoropolyether grafted graphene oxide (PFPE-GO).

FIG. 192. Exemplary process for grafting poly (2,5-benzimidazole) onto graphene oxide to form ABPBI-GO.

FIG. 193. Structure of poly (3,4-benzimidazole) grafted onto graphene oxide to form ABPBI-GO.

FIG. 194. Various graphene oxide structures comprising Hofmann, Ruess, Scholz-Boehn, and Lerf-Klinowski topographies.

FIG. 195. Schematic representation of methanol membrane cross-over with and without carbon nano-flake interfacial coating.

FIG. 196. Summary of exemplary inventive elements in fabricated ion exchange membrane including support skeleton; polymers and variants thereof comprising (without limitation) PFSA, PFSA-PTFE, SPAES, SPEEK, PVA, PBI and CS; including sulfonated functional groups, ionomeric membrane, pillar link bridging membrane to endoskeleton, and pores created by sacrificial fillers. Permanent fillers include functionalized graphene oxides including PFPE-GO, ABPBI-GO and topographical variation thereof; along with carbon nanotubes functionalized by SO₃H, COOH, POH, —NH₂, SiO₂, or TiO₂.

FIG. 197. Schematic representation of silicates categorized as amorphous silicon dioxide, tetrahedral nesosilicates, and mesostructured silica cellular foam including semi-hollow spheroids.

FIG. 198. Exemplary process for synthesizing phosphorylated hollow mesoporous silica phosphoric acid (HMS-PA) nanospheres from silica mesostructured cellular foam.

FIG. 199. Exemplary process for synthesizing functionalized nanospheres comprising silica mesostructured cellular foam with sulfonic acid termini (MCF-SO₃H).

FIG. 200. Schematic representation of protonic polymer conduction via charge hopping between ionomeric polymer and sulfonated mesostructured cellular foam nanospheres.

FIG. 201. Schematic representation of polymer conduction via vehicular transport of protons via hydronium ion electric drift and/or diffusion.

FIG. 202. Exemplary processes for doping a polymer such as sPEES with amino-functionalized and sulfonated mesostructured cellular foam nanospheres to form filler doped membranes sPEES-MCF-NH₂ and sPEES-MCF-HSO₃ respectively.

FIG. 203. Exemplary process for self assembly of aluminum-substituted mesoporous silica as a MCF-ionomer.

FIG. 204. Exemplary process for the synthesis of a poly(m-phenylene)-bibenzimidazole) membrane doped with aluminum-grafted mesoporous silica cellular foam filler (mPBI-MCF).

FIG. 205. Summary of exemplary inventive elements in fabricated ion exchange membrane including support skeleton; polymers and variants thereof comprising (without limitation) PFSA, PFSA-PTFE, SPAES, SPEEK, PVA, PBI and CS; including sulfonated functional groups, ionomeric membrane, pillar link bridging membrane to endoskeleton, and pores created by sacrificial fillers. Permanent fillers include phosphoric acid doped hollow mesoporous silica (HMS-PA), mesostructured cellular foam (MCF-SO₃H, hydroxy MCF, MCF-NH₂), and/or mesoporous silica Al-grafted MCF ionomer.

FIG. 206A. Exemplary process for the synthesis of perfluoro-methylene-methyl-dioxolane monomers (PFMMD/PFMDD monomers).

FIG. 206B. Exemplary process for the synthesis of a perfluoro-2-hydro-2,4-dimethyl-1,3-dioxolanes (PFMMD/PFMDD polymerizers).

FIG. 206C. Exemplary process for the synthesis of perfluoro-2-methylene-4-methyl-1,3-dioxolane (PFMMD/PFMDD polymers).

FIG. 206D. Structural variants of perfluoro (methylene-r) dioxolane moieties PF(Mᵣ)D including PFMD, PFMMD, and PDMDD.

FIG. 207. Process flow for synthesizing PFMMD and PFMDD copolymers with PFMD and CTFE.

FIG. 208. Process flow for synthesizing a copolymer of PFMMD and PFSt.

FIG. 209A. Chemical structure comparison of perfluoro-2-methylene-4-methyl-1,3-dioxolane-perfluorosulfonic acid (PFMMD-PFSA) linear copolymer to conventional PFSA-PTFE composite polymers.

FIG. 209B. Cross sectional comparison of perfluoro-2-methylene-4-methyl-1,3-dioxolane-perfluorosulfonic acid (PFMMD-PFSA) linear copolymer to conventional PFSA-PTFE composite polymers.

FIG. 210. Exemplary process for fabricating a linear fluorinated methylated copolymer PFMMD-co-PFSA comprising perfluoro-2-methylene-4-methyl-1,3-dioxolane and perfluorosulfonic acid.

FIG. 211A. Structural chemical representation of a linear tri-copolymer of perfluoro-2-methylene-4-methyl-1,3-dioxolane (PFMMD) with perfluoro-2-methylene-1,3-dioxolane (PFMD) and perfluorosulfonic acid (PFSA).

FIG. 211B. Structural chemical representation of a linear tri-copolymer of perfluoro-2-methylene-4,5-dimethyl-1,3-dioxolane (PFMDD) with perfluoro-2-methylene-1,3-dioxolane (PFMD) and perfluorosulfonic acid (PFSA).

FIG. 211C. Structural chemical representation of a linear tri-copolymer of perfluoro-2-methylene-4-methyl-1,3-dioxolane (PFMMD) with chlorotrifluoroethylene (CTFE) and perfluorosulfonic acid (PFSA).

FIG. 211D. Structural chemical representation of a linear tri-copolymer of perfluoro-2-methylene-4,5-dimethyl-1,3-dioxolane (PFMDD) with chlorotrifluoroethylene (CTFE) and perfluoro-sulfonic acid (PFSA).

FIG. 211E. Structural chemical representation of a linear tri-copolymer of perfluoro-2-methylene-4-methyl-1,3-dioxolane (PFMMD) with pentafluorostyrene (PFSt) and perfluorosulfonic acid (PFSA).

FIG. 211F. Structural chemical representation of a linear tri-copolymer of perfluoro-2-methylene-17 4,5-dimethyl-1,3-dioxolane (PFMDD) with (PFSt) and perfluorosulfonic acid (PFSA).

FIG. 212. Summary of exemplary inventive elements in fabricated ion exchange membrane including support skeleton; copolymers of perfluoro-2-methylene-4-methyl-1,3-dioxolane and perfluorosulfonic acid (PFMMD-co-PFSA) and numerous variants thereof; including sulfonated functional groups, ionomeric membrane, pillar link bridging membrane to endoskeleton, and pores created by sacrificial fillers.

FIG. 213. Exemplary process for fabricating poly(2,5-dioxo-2,5-dihydro-1H-pyrrole-1-carbonyl) sulfanoyl fluoride-co-styrene (PDDP-CSFS).

FIG. 214. Exemplary process for converting 4-(phenylsulfonyl)-1,1′-biphenyl (Pmax-1200) into sulfonated 4-(phenylsulfonyl)-1,1′-biphenyl (SPmax-1200).

FIG. 215A. Exemplary process for fabricating a hybrid copolymer of poly(2,5-dioxo-2,5-dihydro-1H-pyrrole-1-carbonyl) sulfanoyl fluoride-co-styrene and high X sulfonated 4-(phenylsulfonyl)-1,1′-biphenyl (PDDP-CSFS-co-SPmax-1200).

FIG. 215B. Chemical representation of copolymer PDDP-CSFS-co-SPmax.

FIG. 216. Summary of exemplary inventive elements in fabricated ion exchange membrane including support skeleton; copolymers of poly (2,5-dioxo-2,5-dihydro-1H-pyrrole-1-carbonyl) sulfanoyl fluoride-co-styrene with high χ sulfonated 4-(phenylsulfonyl)-1,1′-biphenyl (PDDP-CSFS-co-SPmax-1200) and variants thereof; including sulfonated functional groups, ionomeric membrane, pillar link bridging membrane to endoskeleton, and pores created by sacrificial fillers.

FIG. 217. Exemplary process for fabricating of phenyl-alkane copolymer, steps 1 monomer and 2 polymerization.

FIG. 218. Exemplary process for fabricating of phenyl-alkane copolymer, step 3 sulfonation.

FIG. 219. Exemplary process for fabricating of phenyl-alkane copolymer, step 4, cross linking.

FIG. 220. Alternative process for fabricating of phenyl-alkane copolymer.

FIG. 221. Exemplary process for fabricating of phenyl-aldehyde.

FIG. 222. Summary of exemplary inventive elements in fabricated ion exchange membrane including support skeleton; sulfonated phenyl-co-alkane (sPh-CₙH₂ₙ₊₂) and sulfonated phenyl-co-aldehyde (sPh-CHO) copolymers and variants thereof; including sulfonated functional groups, ionomeric membrane, pillar link bridging membrane to endoskeleton, and pores created by sacrificial fillers.

FIG. 223. Exemplary chemical formulation of linear and cross-linked poly(trifluorostyrene) PTFS and PTFS-X.

FIG. 224. Exemplary chemical formulation of copolymer of polystyrene and polystyrene-sulfonate (PS-co-sPSS).

FIG. 225. Exemplary chemical formulation of polystyrene sulfonic acid (PSSA) grafted onto perfluoroalkoxy alkane (PFA) polymer.

FIG. 226A. Chemical structure of copolymer of thermoplastic polyurethane and sulfonated divinyl benzene (PTPU-co-sDVB).

FIG. 226B. Chemical structure of tri-copolymer comprising thermoplastic urethane (TPU) crosslinked to polystyrene sulfonate (PSS) through sulfonated divinyl benzene (sDVB).

FIG. 227. Schematic representation of linear block copolymer of flexible polyurethane (PTU ester) and semi-rigid PTU backbone cross linked to polystyrene sulfonate (PSS) via sulfonated divinyl benzene (sDVB).

FIG. 228. Summary of exemplary inventive elements in fabricated ion exchange membrane including support skeleton; with polymers comprising linear and cross-linked sulfonated poly(trifluorostyrene) (sPTFS/sPTFS-X), polystyrene-co-polystyrene-sulfonate copolymers (PS-co-sPSS), polystyrene sulfonic acid grafted onto perfluoroalkoxy alkane (PFA-g-PSSA), and styrene-urethane copolymer comprising thermoplastic polyurethane bonded to divinyl benzene vias polystyrene sulfonate with variants thereof; including sulfonated functional groups, ionomeric membrane, pillar link bridging membrane to endoskeleton, and pores created by sacrificial fillers.

FIG. 229. Exemplary representation of a polysulfone (PSU, PSf) molecule.

FIG. 230. Exemplary process for synthesizing a sulfonated polysulfone (sPSU, sPSf) polymer.

FIG. 231. Summary of exemplary inventive elements in fabricated ion exchange membrane including support skeleton; sulfonated polysulfone (sPSU, sPSf) polymer and variants thereof; sulfonated functional groups, ionomeric membrane, pillar link bridging membrane to endoskeleton, and pores created by sacrificial fillers.

FIG. 232. Exemplary process for synthesizing sulfonimide with a benzoic acid radical.

FIG. 233A. Exemplary process for copolymerization of sulfonated polyamide (SPA) and sulfonimide (Slm) to form poly (sulfonated polyamide sulfonimide).

FIG. 233B. Exemplary process for copolymerization of functionalized sulfonated polyamide (sSPA) and sulfonimide (Slm) to form functionalized copolymer sSPA-co-Slm.

FIG. 234. Summary of exemplary inventive elements in fabricated ion exchange membrane including support skeleton; sulfonated polyamide sulfonimide linear copolymer and variants thereof; including sulfonated functional groups, ionomeric membrane, pillar link bridging membrane to endoskeleton, and pores created by sacrificial fillers.

FIG. 235A. Exemplary process for synthesizing poly-sulfonated phosphazene P(sPz) from a phosphazene P(Pz) monomer.

FIG. 235B. Heteropolymer comprising poly-sulfonated phosphazene P(sPz) and un-sulfonated phosphazene P(Pz).

FIG. 236. Summary of exemplary inventive elements in fabricated ion exchange membrane including support skeleton; sulfonated phosphazene polymer and variants thereof; including sulfonated functional groups, ionomeric membrane, pillar link bridging membrane to endoskeleton, and pores created by sacrificial fillers.

FIG. 237. Chemical representation of poly sulfonated siloxane P(SSiX).

FIG. 238. Summary of exemplary inventive elements in fabricated ion exchange membrane including support skeleton; sulfonated siloxane polymer and variants thereof; including sulfonated functional groups, ionomeric membrane, pillar link bridging membrane to endoskeleton, and pores created by sacrificial fillers.

FIG. 239. Chemical representations of various triazine moieties.

FIG. 240. Exemplary process for synthesizing a covalent triazine framework comprising triazine.

FIG. 241. Exemplary processes for synthesizing various topologies of covalent triazine frameworks including a twelve-element s6T6Ph sCTF-12 comprising six triazine groups and six sulfonated phenols, a s3T6Ph sCTF-9 with a nine element ring comprising three triazine groups and six sulfonated phenols, and a twelve-element 6T6Ph-F₄ CTF-12 comprising six triazine groups and six F₄ fluorinated phenol rings.

FIG. 242. Chemical representations of three different phosphoric acid (H₃PO₄) functionalized covalent triazine frameworks (CTF) comprising phenylated triazine (CTF-Ph), tris(4-formylphenyl)amine (CTF-TPA), and triazine trifluoride (CTF-TF).

FIG. 243A. Chemical representation of a twenty-four element (6T12Ph6bPy)-configured sTCF-24 sulfonated covalent triazine framework comprising 6 triazine, 12 phenols, and 6 bi-pyrroles.

FIG. 243B. Exemplary process for copolymerizing covalent triazine framework (CTF) with polyvinylidene fluoride (PVDF) to form covalent triazine framework polyvinylidene fluoride copolymer CTG-co-PVDF.

FIG. 243C. Chemical representation of a twenty-four element 6Y18Ph configured sCTF-24 sulfonated covalent triazine framework comprising 6 triazine and 18 sulfonated phenol groups with intercalated Pd catalyst.

FIG. 244. Exemplary process for doping a triazine substrate with phosphoric acid (H₃PO₄).

FIG. 245. Chemical representation of sulfonated poly(arylene ether sulfone) triazine bisphenol linear copolymer P(SPAES)-co-TBPh comprising triazine-containing bisphenols and functional group (BPhSf).

FIG. 246. Summary of exemplary inventive elements in fabricated ion exchange membrane including support skeleton; covalent triazine framework polyvinylidene fluoride copolymer (CTF-co-PVDF), phosphoric-doped triazine substrate, and variants thereof; including sulfonated functional groups, ionomeric membrane, pillar link bridging membrane to endoskeleton, and pores created by sacrificial fillers.

FIG. 247A. Exemplary process for synthesizing sBVlm-TfO-co-MMA sulfobutyl-vinylimidazolium-trifluoro methane sulfonate-co-methyl methacrylate.

FIG. 247B. Exemplary process for polymerizing methyl methacrylate (MMA) monomer into non-functionalized electrical insulating poly(methyl methacrylate) (PMMA).

FIG. 248. Chemical representation of various methacrylate monomers including methacrylate (MA), methacrylate acid (MAA), methyl methacrylate (MMA), butyl methacrylate (BMA), and hydroxyethyl methacrylate (HEMA).

FIG. 249. Exemplary processes for synthesizing poly(methyl methacrylate) nanospheres (PMMA-NS).

FIG. 250. Exemplary process for converting methyl methacrylate-ran-methacrylic acid (MMA-MAA) into Pd-poly(methyl methacrylate) nanospheres (Pd PMMA NS).

FIG. 251. Chemical representation of carboxylate Pd bridging of methyl methacrylate-ran-methacrylic acid chain (Pd-MMA-MAA) including symmetrical, asymmetrical, coordinated and non-coordinated bridges.

FIG. 252. Exemplary process for reducing Pd²⁺ ions into Pd⁰ nanoclusters using a benzene-methanol solution of Pd(CH₃COO)₂-poly(methyl methacrylate-ran-methacrylic acid) (MMA-MAA).

FIG. 253. Exemplary process for synthesizing PPMA nanospheres, then functionalizing and sulfonating the nanosphere surface with SO₃H.

FIG. 254. Generalized process for converting functionalized PMMA nanospheres into ionomer coated nanospheres.

FIG. 255. Exemplary process for synthesizing PPMA nanospheres then converting them into porous nanospheres.

FIG. 256A. Exemplary process for synthesizing poly methyl methacrylate zinc nanoclusters (PMMA Zn NCs) then sulfonating the zinc to form poly methyl methacrylate with sulfonated zinc nanoclusters (PMMA sZn NCs).

FIG. 256B. Inventive process to convert poly methyl methacrylate zinc nanospheres or nanoclusters (PMMA Zn²⁺ NS/NC) into zinc-oxide functionalized PMMA nanospheres or nanoclusters (PMMA ZnO NS/NC).

FIG. 257. Chemical representation of poly methyl methacrylate (PMMA) isometries including isotactic, syndiotactic, and atactic configurations.

FIG. 258. Exemplary process for grafting poly(methyl methacrylate) onto polyester to form grafted polymer PE-g-PMMA.

FIG. 259. Comparison of chemical representations for various polymers of poly(methyl methacrylate) including linear copolymers of PMMA with maleic anhydride (MAH) and with maleic anhydride derivative (MI) to form poly(MMA-co-MAH) and poly(MMA-co-MAF-co-MI).

FIG. 260. Exemplary process for grafting methyl methacrylate MMA onto a polyvinylidene fluoride polymeric chain PCDF to form the copolymer PVDC-g-MMA.

FIG. 261. Exemplary process for forming a liner copolymer of maleic anhydride MA and methyl methacrylate (MMA) to synthesize PMMA-co-MAH.

FIG. 262. Summary of exemplary inventive elements in fabricated ion exchange membrane including support skeleton; polymeric membranes comprising pure poly methyl methacrylate (PMMA), copolymers of PMMA with maleic anhydride (PMMA-co-MAH), copolymers of PMMA with maleic anhydride derivative (PMMA-co-MAH-co-Mi), grafted polymers of PMMA and polyvinylidene fluoride PMMA-g-PVDC and variants thereof; including sulfonated functional groups, ionomeric membrane, pillar link bridging membrane to endoskeleton, and pores created by sacrificial fillers. PPMA polymers may be functionalized by ZnS PMMA nanoclusters, PMMA nanospheres and porous nanosphere either attached to polymeric chains or bridging multiple chains. The ZnS PMMA nanoclusters and PMMA nanospheres may also be used as permanent ionomeric fillers for other polymer films such as those comprising PFSA, PFSA-PTFE, SPAES, SPEEK, PBI and CS mainchains.

FIG. 263. Matrix representation of a hybrid copolymer comprising sulfonated poly (vinyl alcohol) with carboxy methyl cellulose and acrylamide containing carboxylated carbon nanotubes (CCNT) and sulfonated activated carbon (SAC) filler for conduction and cross linking of chains. CNTs may be functionalized by various ionomeric groups such as —COOH, —OH, or —SO₃H groups or by introducing —SO₃H groups using polystyrene sulfuric acid. Activated carbon fillers may be functionalized by —SO₃H. Poly vinyl alcohol may include zinc oxide nanoparticles (not shown) cross-linking the PVA matrix.

FIG. 264. Chemical representation of a PFSA-like fluorocarbon mainchain comprising a multi-acid sidechain (MASC) as a pendant securing an ionomer group such as perfluoro imide acid (PFIA) to the polymeric mainchain. Examples of MASCs comprise pendants containing sulfonyl (O═S═O), thiol (—SH), hydrazine (HN), and difluoromethylene (CF₂).

FIG. 265A. Exemplary processes for forming varying length multi-acid sidechains (MASCs) with an ionomeric terminus comprising sulfonylhydrazide (SO₂—HN—SO₂). Please note that although at first glance the pendants shown on the left right side flow charts may appear identical there are subtle differences in the chain lengths that can affect crystallinity and fuel crossover especially in direct methanol fuel cells (DMFC).

FIG. 265B. Process sequence for converting PFSA into a multi-acid sidechain (MASC) comprising perfluoro bis(sulfonyl) imide-acid (PFIA).

FIG. 265C. Process sequence for converting PFSA into a multi-acid sidechain (MASC) comprising 2-sulfobenzene bissulfonylimide (ortho-bis acid).

FIG. 266. Summary of exemplary inventive elements in fabricated ion exchange membrane including support skeleton; polymer mainchains comprising fluorocarbon and hydrocarbon polymers such as PFSA, PFSA-PTFE, SPAES, SPEEK, PVA, PBI and CS and variants thereof but including multi acid sidechains containing sulfonyl (O═S═O), thiol (—SH), hydrazine (HN), and difluoromethylene (CF₂); and with ionomeric termini including sulfonated functional groups such sulfonic acid or sulfonylhydrazide, ionomeric membrane, pillar link bridging membrane to endoskeleton, and pores created by sacrificial fillers.

FIG. 267. Exemplary processes for forming sulfonated arylene-ether hybrid polymer sP₁₂F₉₇B.

FIG. 268. Exemplary processes for forming sulfonated arylene-ether hybrid polymer sP6F9CB.

FIG. 269. Chemical representation of sulfonated arylene-ether hybrid polymer identifying constituent groups including fluorinated polymer 12F, sulfonated polymers 7BF and CB, and fluorinated sulfonated polymer 6F.

FIG. 270. Summary of exemplary inventive elements in fabricated ion exchange membrane including support skeleton; polymer mainchains comprising sulfonated poly(arylene ether) such as sP12F97B and sP6F9CB and variants thereof; including a sulfonated ionomeric membrane, pillar link bridging membrane to endoskeleton, and pores created by sacrificial fillers.

FIG. 271. Quasi-3D chemical representation of thiol polyhedral oligomeric silsesquioxanes (POSS-SH).

FIG. 272. Exemplary processes for synthesis of phosphoric polyhedral oligomeric silsesquioxanes comprising conversion of 3-mercaptopropyl trimethoxysilane (3-MPTMS) into thiol polyhedral oligomeric silsesquioxanes (POSS-SH) then functionalized by ethylene glycol methacrylate phosphate (EGMP) to produce POSS-S-PA.

FIG. 273. Quasi-3D representation of phosphoric acid polyhedral oligomeric silsesquioxanes (POSS-S-PA).

FIG. 274. Quasi-3D representations of various generic polyhedral oligomeric silsesquioxanes including polyhedral oligomeric SSQ with R radical (POSS-R), octagonal prism SSQ with no radicals (POSS), and octagonal prism SSQ with radicals R (POSS-R).

FIG. 275. Exemplary processes for synthesis of polyethylene glycol polyhedral oligomeric silsesquioxanes (POSS-PEG).

FIG. 276. Chemical representations of a several variants of polyhedral oligomeric silsesquioxanes comprising isobutyl polyhedral oligomeric SSQ (POSS-iBu), vinyl polyhedral oligomeric SSQ (POSS-Vi), and 1-chlorobutane polyhedral oligomeric SSQ (POSS-8Cl).

FIG. 277. Chemical representations of a several variants of polyhedral oligomeric silsesquioxanes comprising octakis (dimethylsilyloxy) polyhedral oligomeric SSQ (Ot-POSS), octavinyl polyhedral oligomeric SSQ (OV-POSS), and octaphenyl polyhedral oligomeric SSQ (Ph-POSS).

FIG. 278. Chemical representations of a several variants of polyhedral oligomeric silsesquioxanes comprising isobutyl-vinyl polyhedral oligomeric SSQ (POSS-iBu-Vi), isobutyl-butylamine polyhedral oligomeric SSQ (POSS-iBu-NH₂), and isobutyl-CI polyhedral oligomeric SSQ (POSS-iBu-CI).

FIG. 279. Chemical representations of a several variants of polyhedral oligomeric silsesquioxanes comprising isobutyl-hydroxide polyhedral oligomeric SSQ (POSS-iBu-3OH), isobutyl-styryl polyhedral oligomeric SSQ (POSS-iBu-styryl), and isobutyl-polystyrene polyhedral oligomeric SSQ (POSS-iBu-PS).

FIG. 280. Chemical representations of a several variants of polyhedral oligomeric silsesquioxanes comprising R-styryl polyhedral oligomeric SSQ (POSS-R-styryl), and R-polystyrene polyhedral oligomeric SSQ (POSS-R—PS).

FIG. 281A. Chemical representations of variants of polyhedral oligomeric silsesquioxanes comprising cyclopentyl-polystyrene polyhedral oligomeric SSQ (POSS-Cp-PS), and cyclohexyl-polystyrene polyhedral oligomeric SSQ (POSS-Cy-PS).

FIG. 281B. Chemical representations of variants of polyhedral oligomeric silsesquioxanes comprising polyhedral oligomeric SSQvariants aminopropylisobutyl (POSS-Am—NH₂); mercaptopropyl-isobutyl (POSS-SH); mono(acryloisobutyl) (POSS-A).

FIG. 282. Chemical representations of a several variants of polyhedral oligomeric silsesquioxanes comprising polyhedral oligomeric SSQ (POSS-Am—NH₂), polyhedral oligomeric SSQ (POSS-SH), and polyhedral oligomeric SSQ (POSS-A).

FIG. 283. Graphical representation of various polyhedral oligomeric silsesquioxanes topographies including unreactive POSS, 1D POSS elements including pendants, caps, and barbells; planar POSS chains and lattices; and 3D POSS dendrites and three-dimensional matrices.

FIG. 284. Exemplary processes for synthesis of 3,13-dihydrooctaphenyl double decker silsesquioxane (DDSQ) FIG. 285. Graphical representations of various double-decker silsesquioxanes including non-methylated functionalized double-decker silsesquioxane (NMe DDSQ) and methylated functionalized double-decker silsesquioxane (Me DDSQ).

FIG. 286A. Exemplary functional groups for double-decker silsesquioxanes and resulting SiO₂ bonding comprising vinyl, methylpropyl, methyltrichlorosilane, dichloromethylvinylsilane, and others.

FIG. 286B. Exemplary functional groups for double-decker silsesquioxanes and resulting SiO₂ bonding comprising allyloxytrimethylsilane, propyl glycidyl ether, and others.

FIG. 286C. Exemplary functional groups for double-decker silsesquioxanes and resulting SiO₂ bonding comprising 4-bromostyrene, 4-acetoxystyrene, and others.

FIG. 287. Structural representations of cubic double-decker silsesquioxanes.

FIG. 288. Exemplary processes for synthesis of functionalized cubic double-decker silsesquioxane.

FIG. 289. Exemplary process for synthesis of amino functionalized cubic double-decker silsesquioxane.

FIG. 290. Chemical constituents of POSS nanocomposites comprising a blend of octameric POSS cages, POSS cage resins, and catalysts.

FIG. 291 Graphical representation of POSS clusters attaching to polymeric backbone of ion exchange membrane (POSS nanostructures not drawn to scale).

FIG. 292. Summary of exemplary inventive elements in fabricated ion exchange membrane including support skeleton; mainchains comprising fluorocarbon and hydrocarbon polymers including such as PFSA, PFSA-PTFE, SPAES, SPEEK, PVA, PBI and CS, and variants thereof; including a sulfonated ionomeric membrane, pillar link bridging membrane to endoskeleton, and pores created by sacrificial fillers. Permanent fillers include polyhedral oligomeric silsesquioxanes (POSS) with chemical and structural variants including POSS-SH, POSS-S-PA, POSS-PEG, POSS-iBu, POSS-Vi, POSS-BCl, Ot-POSS, OV-POSS, Ph-POSS, POSS-iBu-Vi, POSS-iBu-NH₂, POSS-iBu-CI, POSS-iBu-3OH, POS-iBu-styrl, POSS-iBu-PS, POS-R-styrl, POSS-R—PS, POSS-Cp-PS, POSS-Cy-PS, POSS-Am—NH₂, POSS-SH, and POSS-A; POSS cages comprising pendants, beads, chains, barbells, planar, dendritic and 3D structures, along with double-decker silsesquioxanes including cubic, DDSQ, and Me DDSQ moieties.

FIG. 293. Graphical representation of polyimide coating nanocoating of PTFE reinforced PFSA ion exchange membrane illustrating interfacial bonding.

FIG. 294. Graphical representation of polymeric ion exchange membrane with embedded nanocomposites (elements not drawn to scale).

FIG. 295A. Exemplary process for synthesis of nanocoated polymer chains by converting extended polytetrafluoroethylene (ePTFE) into a dopamine composite membrane (DCM) and subsequently treated by ZrO₂ using a sol-gel process to produce a zirconium composite membrane (ZCM).

FIG. 295B. Exemplary process for synthesis of nanocoated polymer chains by converting extended polytetrafluoroethylene (ePTFE) into a dopamine composite membrane (DCM) and subsequently treated by PtO₂ using a sol-gel process to produce a platinum composite membrane (PtCM).

FIG. 296. Exemplary process for synthesis of nanoparticle coated carbon nanotubes involving the steps of polymer wrapping, polyelectrolyte treatment with either polybenzimidazole (PBI) or pyridine polybenzimidazole (PyPBI) and finally nanoparticle attachment.

FIG. 297A. Exemplary process for electrostatic functionalization of carbon nanotubes with amino groups.

FIG. 297B. Exemplary process for coordination bonding of platinum or titanium nanoparticles onto NH₂ functionalized CNTs resulting in platinum amino functionalized nanoparticle coated carbon nanotubes (Pt—NH₂ NP CNT) and titanium amino functionalized nanoparticle coated carbon nanotubes (Ti—NH₂ NP CNT) respectively.

FIG. 298. Exemplary process for tin-platinum coating carbon nanotubes.

FIG. 299. Graphical representation of polymeric ion exchange membrane with embedded functionalized carbon nanotubes (not to scale).

FIG. 300. Graphical representation of polymeric ion exchange membrane with embedded nanosphere coated carbon nanotubes (not to scale).

FIG. 301. Chemical representations of a hybrid polymer comprising sulfonated glutaraldehyde (sGA) cross-linked copolymers 4-sulfophthalic acid (SPA) and poly vinyl alcohol (PVA) including PVA bound polyethylene oxide (PEO) and phosphorated titania carbon nanotubes (PO₄TiO₂).

FIG. 302. Exemplary process for radiation induced defect and methylene grafting of ionomer onto a base polymer.

FIG. 303. Schematic representation of nanofiber electrospinning process.

FIG. 304. Schematic representation of hybrid polymer containing a polymeric backbone with embedded sulfonated polystyrene nanofibers (sPS).

FIG. 305A. Process sequence for DPA doping of PFSA using membrane swelling pore generation.

FIG. 305B. Exemplary processes for hybrid polymer or nanofiber synthesis from dopamine (DA) or sulfonated dopamine (sDA) into insulating poly(dopamine) (pDA), ionomeric poly (sulfonated dopamine) (pSDA), or ionomeric linear copolymer poly (dopamine-co-sulfonated dopamine) (p(DA-sDA).

FIG. 305C. Schematic representation of a poly(dopamine-sulfonated dopamine) doped perfluoro sulfonic acid-polytetrafluoroethylene (PFSA-PTFE·P(DA-sDA)).

FIG. 305D. Process for DPA doping of polymer membrane using inventive sacrificial filler method to form membrane vacancies to contain the dopant.

FIG. 306A. Exemplary processes for hybrid polymer synthesis of an antibacterial dopamine substrate with silver nanoparticle coating.

FIG. 306B. Exemplary processes for hybrid polymer synthesis of a dopamine matrix integrating platinum catalyst, sulfonic acid functionalized nanoparticles, and cobalt scavenger coating.

FIG. 307. Summary of exemplary inventive elements in fabricated ion exchange membrane including support skeleton; polymer mainchains comprising fluorocarbon and hydrocarbon polymers including such as PFSA, PFSA-PTFE, SPAES, SPEEK, PVA, PBI and CS, and variants thereof; including a sulfonated ionomeric membrane, pillar link bridging membrane to endoskeleton, and pores created by sacrificial fillers. Nano coatings include functionalized polyimide, nanocomposites, and silver nanoparticles. Permanent fillers include functionalized and nanosphere coated carbon nanotubes, poly dopamine composite membranes, zirconium composite membranes, sol-gel matrix fillers comprising titanium and catalysts, and electrospun nanofibers.

FIG. 308. Schematic representation of intercalant zirconium (iZr).

FIG. 309. Moieties of intercalant zirconium including a type Zr with OH terminus, γ type Zr with 2O termini, and A type Zr with X and Y termini where X=F⁻, Cl⁻, Br⁻, OH⁻, HSO₄ and where Y=H₂O, DMSO. As depicted zirconia may occupy multiple parallel planes.

FIG. 310. Exemplary processes for converting polyethersulfone into polydopamine sodium bicarbonate then reduced into zirconium nanospheres.

FIG. 311. Representation of effect of ZrO₂ nanosphere on IEM charge conduction.

FIG. 312. Summary of exemplary inventive elements in fabricated ion exchange membrane including support skeleton; polymer mainchains comprising fluorocarbon and hydrocarbon polymers including such as PFSA, PFSA-PTFE, SPAES, SPEEK, PVA, PBI and CS, and variants thereof; including a sulfonated ionomeric membrane, pillar link bridging membrane to endoskeleton, and pores created by sacrificial fillers. As shown, zirconium fillers may include intercalant zirconium and zirconium nanospheres.

FIG. 313. Graphical representation of various clusters of metal oxide frameworks (MOFs) including metal-to-organic (M2O) ligand and metal-to-metal (M2M) ligands. Examples in include varying coordination numbers and topologies including convex or starburst MOF with CN=6, cluster MOF with CN=6, and three-dimensional concave MOF with CN=3 arranged in a cubic metal matrix.

FIG. 314. Graphical representation of a three-dimensional cubic metal oxide frameworks (MOFs) comprising a rectangular or square array with CN=6 including metal-to-organic (M2O) ligand and metal-to-metal (M2M) ligands.

FIG. 315. Graphical representation of a three-dimensional metal organic framework geometries without guest molecule including cubic. trapezoid, double trapezoid, hexagonal drum (not shown), and octangular drum. For clarity, only metal-to-metal (M2M) ligands are shown.

FIG. 316. Graphical representation of a three-dimensional metal organic framework geometries with guest molecules shown including cubic. trapezoid, double trapezoid, hexagonal drum (not shown), and octangular drum. For clarity, only metal-to-metal (M2M) ligands are shown.

FIG. 317. Graphical representations of metal oxide frameworks including atomic stack of metals (left), sulfonated double trapezoidal MOF (center), and PFSA-PTFE membrane with embedded MOFs (right).

FIG. 318. Graphical representation of MOF-to-MOF and MOF-to-polymer bonding.

FIG. 319. Exemplary processes for forming MOF with Zr₆O₄(OH)₄ metal clusters from benzene-1,2,4,5-tetracarboxylic acid (H₄BTC) and zirconium(IV) chloride (ZrCl₄).

FIG. 320. Graphical representation of zinc acetate metal complex (Zn₄O(CH₃CO₂)₆) with CN=4.

FIG. 321. Exemplary process for synthesizing ferrous MOF modified ion exchange ionomer Fe-MIL-101-NH₂—PPO—SO₂Cl from poly phenylene oxide sulfuryl chloride (PPO-SO₂Cl) and amine metal oxide framework (C₂₄H₁₅ClFe₃N₃O₁₃).

FIG. 322. Exemplary process for synthesizing chromium terephthalate metal cluster MIL-101(Cr).

FIG. 323. Graphical comparison of ligands in metal oxide frameworks (MOFs) with varying ratios of proton sources (OS) to proton hopping sites (PHS).

FIG. 324. Graphical representation of inventive heterogenous MOFs comprising catalyst and scavenger metals include scavengers located on metal sites (left), ligands (center), and guests (right).

FIG. 325. Graphical representation of inventive heterogenous MOFs comprising catalyst and scavenger metals arranged in interleaved planes without guests.

FIG. 326. Graphical representation of inventive heterogenous MOFs comprising catalyst and scavenger metals arranged in interleaved planes with intercalated guests (left) and stacked guests (right).

FIG. 327. Excerpted periodic table of elements highlighting transition metals aka D-block elements including platinum noble metal groups, the table illustrating atomic numbers, exemplary orbitals, and elemental RoHS risks of toxicity, safety, and radioactivity.

FIG. 328. Graph of bonding dissociation energies for select period 4, 5, and 6 transition metals.

FIG. 329A. Chemical representations of heterogenous M-L-M bonding identifying organic ligands applicable for Fe-to-Pt MOFs including metal dithiolene, metal 1,2-ethanedithiol, and metal pyridoxal-thiosemicarbazone.

FIG. 329B. Chemical representations of heterogenous M-L-M bonding identifying organic ligands applicable for Fe-to-Ti MOFs including metal Schiff base, metal salicylaldehyde, metal ethylenediamine.

FIG. 329C. Chemical representations of heterogenous M-L-M bonding identifying organic ligands applicable for Fe-to-Ti MOFs including metal imidazophenanthroline carboxylate and metal succinate.

FIG. 330A. Chemical representations of heterogenous M-L-M bonding identifying organic ligands applicable for Co-to-Pt MOFs including metal-1,2-bis(diphenylphosphino)ethane, metal bidentate phosphine, and metal-2,2′-bipyridine.

FIG. 330B. Chemical representations of heterogenous M-L-M bonding identifying organic ligands applicable for Co-to-Pt MOFs including metal dithiolene, metal 1,2-ethanedithiol, and metal pyridoxal-thiosemicarbazone.

FIG. 331A. Chemical representations of heterogenous M-L-M bonding identifying organic ligands applicable for Ni-to-Pt MOFs including metal ambidentate, metal 1,2-bis(diphenylphosphino)ethane, and metal 2,2′-bipyridine.

FIG. 331B. Chemical representations of heterogenous M-L-M bonding identifying organic ligands applicable for Ni-to-Ti MOFs including metal Schiff base, metal salicylaldehyde, and metal ethylenediamine.

FIG. 332. Pseudo-3D chemical representation of a zinc hexaphosphate ester based metal-organic framework illustrating guest molecular containment.

FIG. 333A. Process for MOF doping of polymer using inventive sacrificial filler method to form membrane vacancies to contain the dopant.

FIG. 333B. Pseudo-structural representation of an ion exchange membrane containing triazole-grafted poly(vinylbenzyl chloride) (C₂H₃N₃-g-PVC) as an alternative to MOF fillers for high temperature PEMs.

FIG. 334. Summary of exemplary inventive elements in fabricated ion exchange membrane including support skeleton; polymer mainchains comprising fluorocarbon and hydrocarbon polymers including such as PFSA, PFSA-PTFE, SPAES, SPEEK, PVA, PBI and CS, and variants thereof; including a sulfonated ionomeric membrane, pillar link bridging membrane to endoskeleton, and pores created by sacrificial fillers. Metal organic framework (MOFs) fillers of varying geometric configurations include cubic, tetrahedral, double tetrahedral, hexagonal, octagonal, and planar sheets containing metals and metal complexes, functionalized by the metal complexes, ligands, or guests. Metal complexes include zinc-oxide hexaphosphate ester, chromium terephthalate, sulfonated ferrous clusters, zinc acetate, and zirconium based compounds such as Zr₆O₄(OH)₄. A novel class of heterogenous MOFs comprising a mix or catalytic or ionomeric metals with scavenger metals protecting the film from CO and toxic poisoning is also represented in varying intercalated and interleaved MOF geometries employing M-L-M ligands including M₁-dithiolene-M₂, M₁-EDT-M₂, M₁-PLTSC-M₂, M₁-ambidentate-M₂, M₁-DPPE-M₂, M₁-BIPY-M₂, M₁-salicylaldehyde-M₂, M₁-Schiff bases-M₂ and others.

FIG. 335. Exemplary process for synthesizing molybdenum-tungsten nanoparticles and their inclusion into or upon an ion exchange membrane.

FIG. 336. Molecular representation of phosphotungstic acid doped silica matrix.

FIG. 337. Exemplary process for synthesizing ferrocyanide-coordinated poly(4-vinylpyridine) (CP4VP) using water or methanol pathways.

FIG. 338. Molecular representation of ion exchange membrane comprising phosphotungstic acid (PWA) doped poly(4-vinylpyridine) (P4VP) polymers with ferrocyanide-coordinated poly(4-vinylpyridine) (CP4VP) ionomers embedded in a polysulfone (PSU, PSf) membrane.

FIG. 339. Molecular representation of ion exchange membrane comprising phosphotungstic acid (PWA) doped quaternized polyethyleneimine (QPEI) with R₄N⁺ ionomers embedded in a poly vinyl alcohol (PVA) membrane.

FIG. 340. Summary of exemplary inventive elements in fabricated ion exchange membrane including support skeleton; polymer mainchains comprising fluorocarbon and hydrocarbon polymers including such as PFSA, PFSA-PTFE, SPAES, SPEEK, PVA, PBI, and CS, and variants thereof such as poly(4-vinylpyridine) (P4VP) and quaternized polyethyleneimine (QPEI); including a ionomeric membrane comprising CP4VP, R₄N⁺ and sulfonic ionomers, pillar link bridging membrane to endoskeleton, and pores created by sacrificial fillers. Exemplary permanent tungsten fillers include molybdenum tungsten nanoparticles (Mo-W NPs) and phosphotungstic acid (PWA) crystals.

FIG. 341. Molecular and pseudo-structural representations of zeolite.

FIG. 342. Exemplary process depicting synthesis of sulfonic acid functionalized zeolite substrates using 2-(4-chlorosulfonilphenyl) ethyltrimethoxysilane (C₁₁H₁₇ClO₅SSi).

FIG. 343. Exemplary process for bonding sulfonic acid onto a zeolite molecule via using 2-(4-chlorosulfonilphenyl) ethyltrimethoxysilane (C₁₁H₁₇ClO₅SSi).

FIG. 344. Exemplary process depicting synthesis of sulfonic acid functionalized zeolite substrates using mercaptopropyltrimethoxysilane (C₆H₁₆O₃SSi).

FIG. 345. Pseudo-structural representation of zeolite identifying various bonding regions.

FIG. 346. Pseudo-structural representation of various zeolite crystals.

FIG. 347. Pseudo-structural representation of zeolite identifying main, side, and link channels having differing pore sizes.

FIG. 348. Exemplary process for synthesis of sulfonated mordenite using a silane linker.

FIG. 349. Exemplary process for synthesis of zeolite nanoparticles housing catalytic or ionomeric guests.

FIG. 350. Summary of exemplary inventive elements in fabricated ion exchange membrane including support skeleton; polymer mainchains comprising fluorocarbon and hydrocarbon polymers including such as PFSA, PFSA-PTFE, SPAES, SPEEK, PVA, PBI, and CS, and variants thereof; including a ionomeric membrane comprising sulfonic ionomers, pillar link bridging membrane to endoskeleton, and pores created by sacrificial fillers. Zeolite fillers shown include phenyl zeolite, sulfonated mordenite, sulfonated zeolite substrates, and functionalized zeolite nanoparticles.

FIG. 351. Chemical representation of various sulfone moieties including polyether sulfone (PES), Udel polysulfone (PSU, PSf), and polyphenyl sulfone (PPSf, PPSU).

FIG. 352. Exemplary process for sulfonating Udel polysulfone into sulfonated polysulfone (sPSf, PPSU).

FIG. 353. Exemplary process for bromating Udel polysulfone into bromated polysulfone (BrPSf, BrPSU).

FIG. 354. Exemplary process for cross-linking bromated polysulfone into para-linked bromated polysulfone (BrPSf)ₓ or (BrPSU)ₓ.

FIG. 355. Exemplary process for synthesizing Udel polysulfone from 4,4′-dichlorodiphenyl sulfone.

FIG. 356. Alternate process for sulfonating Udel polysulfone into sulfonated polysulfone (sPSf, sPSU).

FIG. 357. Exemplary process for synthesizing functionalized polymer graphene oxide sulfonated polysulfone (FPGO-sPSU, FPGO-sPSf) from sulfonated polysulfone and graphene oxide including resulting GO topography therefrom.

FIG. 358. Detailed chemical representation of functionalized polymer graphene oxide sulfonated polysulfone (FPGO-sPSU, FPGO-sPSf) with inset showing GO topography.

FIG. 359. Exemplary process for synthesizing platinum titanium dioxide nanoparticles (Pt-TiO₂ NPs) from chloroplatinic acid hydrate and titanium dioxide.

FIG. 360. Schematic representation of a polysulfone (PSU, PSf) membrane containing sulfonated polysulfone polymeric chains with sulfonic acid ionomers, and with Pt-Ti nanoparticles and graphene oxide sulfone (FPGO-sPSU, FPGO-sPSf) fillers. Arrows indicate proton charge transport involves charge hopping among heterogenous conductors including the sulfonic acid ionomers, platinum nanoparticles, and functionalized graphene oxides.

FIG. 361. Schematic representation of an alternative polysulfone (PSf, PSU) membrane of sulfonated polysulfone polymeric chains with sulfonic acid ionomers containing polyoctahedral silsesquioxanes (POSS) fillers. Arrows indicate two forms of charge transport—charge hopping among HSO₃ ionomers, and vehicular transport of hydronium ions assisted by POSS fillers.

FIG. 362. Summary of exemplary inventive elements in fabricated ion exchange membrane including support skeleton; polymer mainchains comprising fluorocarbon and hydrocarbon polymers including such as sPSU or BrPSU or alternatively PFSA, PFSA-PTFE, PVA, SPAES, SPEEK, PBI and CS and variants thereof; including a ionomeric membrane comprising sulfonic ionomers, pillar link bridging membrane to endoskeleton, and pores created by sacrificial fillers. Permanent fillers include polyoctahedral silsesquioxanes (POSS), platinum titanium dioxide nanoparticles (Pt-TiO₂ NPs), and graphene oxide sulfone (FPGO-sPSU).

FIG. 363. Exemplary process for synthesizing a protic ionic liquid (PIL) comprising 1-hexyl-3-vinylimidazoliumdihydrogen phosphate (PHVlm-H₂PO₄).

FIG. 364. Exemplary process for synthesizing 2,2-(p-oxydiphenylene)-5,5-bibenzimidazole (OPBI).

FIG. 365. Exemplary process for forming a OPBI membrane with dihydrogen phosphate doping and a polymeric mainchain comprising poly [2,2-(p-oxydiphenylene)-5,5-bibenzimidazole].

FIG. 366. Exemplary process for synthesizing poly(arylene ether benzimidazole) (PAEBI).

FIG. 367A. Process flow for forming phosphoric acid functionalized PBI.

FIG. 367B. Chemical formula for phosphoric acid functionalizes PBI

FIG. 367C. Chemical representation of various forms of sulfonated poly (p-oxydiphenylene)-bibenzimidazole illustrating different bonding HSO₃ configurations.

FIG. 368A to 368B. Chemical representations of various forms of un-functionalized bibenzimidazole including ABPI, p-PBI or m-PBI, 2OH-PBI, and F₆—PBI, SO₂—PBI, O-PBI, and 20-PBI.

FIG. 369. Chemical representation of cross linking of two PBI chains.

FIG. 370. Exemplary process for synthesizing PBI with sulfone pendant.

FIG. 371. Chemical representations of PBI linker molecules including DBpX, C₈H₈Cl₂, (CH₂═CH)₂SO, B₃Br, Be₃Br, and C₁₄H₁₃NO.

FIG. 372. Process flow for partial crushing electrospun extruded PBI nanofibers and subsequent molding.

FIG. 373. Exemplary process for synthesizing hexachlorocyclotriphosphazene (HCCP) and imidazolechlorocyclotriphosphazene (ImCCP).

FIG. 374. Exemplary process for fabricating an phosphorated membrane comprising a copolymer of OPBI and poly(vinylbenzyl chloride) (PVBC) using quaternary ammonia.

FIG. 375. Chemical representation of a cross-linked copolymer of OPBI and poly(vinylbenzyl chloride) (PVBC) with quaternary ammonia moieties of quinuclidinol, quinuclidine, and DABCO.

FIG. 376. Pseudo-structural representation of ion exchange membrane comprising cross linked OPBI and polyaniline (PANI) functionalized by quaternary ammonia (QA), dihydrogen phosphate, and diphosphate-QA pairs.

FIG. 377. Exemplary process for fabricating a copolymer of PBI and a zeolitic imidazolate framework (ZIF).

FIG. 378. Pseudo-structural representation of ion exchange membrane comprising cross linked PBI and ZIF copolymers.

FIG. 379. Summary of exemplary inventive elements in fabricated ion exchange membrane including support skeleton; polymer mainchains comprising hydrocarbon polymers of poly phenylene)-bibenzimidazole variants OPBI, ABPBI, p-PBI/m-PBI, 2OH-PBI, F₆—PBI, SO₂—PBI, 2OH-PBI, poly(arylene ether benzimidazole) (PAEBI), poly(vinylbenzyl chloride) (PVBC), polyaniline (PANI), PBI copolymers with zeolitic imidazolate frameworks (ZIFs), cross linked OPBI and polyaniline (PANI), or alternatively PFSA, PFSA-PTFE, PVA, SPAES, SPEEK, and CS and variants thereof; including a ionomeric membrane comprising sulfonic or diphosphate ionomers, pillar link bridging membrane to endoskeleton, and pores created by sacrificial fillers. Permanent fillers include electrospun PBI or OPBI nanofibers bound to hexachlorocyclotriphosphazene (HCCP) or imidazolechlorocyclotriphosphazene (ImCCP), quaternary ammonia ionomers and linkers including quinuclidinol, quinuclidine, and DABCO moieties.

FIG. 380. Three exemplary biopolymers—chitosan (CS), cellulose (CE), and alginic acid (AA).

FIG. 381. Exemplary process for forming chitosan (CS) from chitin including one N-acetyl-D-glucosamine and two stereo isomer D-glucosamine segments.

FIG. 382. Exemplary process to sulfonate chitosan using acetic sulfate.

FIG. 383. Exemplary process to sulfonate and crosslink chitosan chains using sulfuric acid.

FIG. 384. Exemplary process to sulfonate chitosan using sulfosalicylic acid.

FIG. 385A. Exemplary process to phosphorylate chitosan using phosphoric acid.

FIG. 385B. Exemplary process to phosphorylate chitosan using a blend of triethyl phosphate, phosphoric acid, and phosphorus pentoxide.

FIG. 385C. Exemplary process to phosphorylate chitosan using a blend of methanesulfonic acid and phosphorus pentoxide.

FIG. 386. Exemplary process for synthesizing a protic ionic liquid (PIL) comprising 1-hexyl-3-vinylimidazoliumdihydrogen phosphate (PHVlm-H₂PO₄).

FIG. 387. Chemical representation of a functionalized copolymer comprising chitosan-co-polyacrylonitrile (CS-co-PAN).

FIG. 388. Chemical representation of a functionalized copolymer comprising chitosan-co-polystyrene (CS-co-PS).

FIG. 389. Chemical representation of a functionalized copolymer comprising chitosan-co-polyvinyl alcohol (CS-co-PVA).

FIG. 390. Chemical representation of a functionalized copolymer comprising chitosan-co-perfluorinated sulfonic acid (CS-co-PFSA).

FIG. 391. Graphical representation of proton conduction in a direct methanol fuel cell comprising the functionalized copolymer chitosan-co-perfluorinated sulfonic acid (CS-co-PFSA).

FIG. 392. Exemplary process to form vinylpyridine grafted chitosan (CS-g-PVP).

FIG. 393. Exemplary process to attach vinylpyridine grafted chitosan onto carboxylated carbon nanotube (CS-g-PVP-CNT).

FIG. 394. Exemplary process to form styrenesulfonic acid grafted chitosan (CS-g-SSA).

FIG. 395. Exemplary process to attach styrenesulfonic acid grafted chitosan onto carboxylated carbon nanotube (CS-g-SSA-CNT).

FIG. 396. Chemical representation of polyhedral oligomeric silsesquioxanes cross-linked chitosan chains (POSS XL-CS).

FIG. 397. Exemplary process to fabricate a nanochain comprising a sulfonated copolymer of polydopamine (PDA) with (3-(3-aminopropyl) dimethylammonio) propane-1-sulfonate (ADPS).

FIG. 398. Schematic representation of the structural composition and conduction mechanisms of a copolymer of sulfonated chitosan and nanochains of polydopamine and ADPS (sCS-co-PDA-co-ADPS-SA).

FIG. 399A. Chemical formulaic representation of a copolymer of cross-linked chitosan and polydopamine (CS-co-PDA) using a glutaraldehyde (GA) cross linker.

FIG. 399B. Chemical formulaic representation of a copolymer of cross-linked chitosan and functionalized polydopamine (CS-co-PDA) using a glutaraldehyde (GA) cross linker, where radical R may comprise sulfonic acid, phosphoric acid, or other ionomers.

FIG. 400. Structural representation sulfonated graphene oxide (sGO) filler for chitosan homopolymer membrane (CS).

FIG. 401A. Exemplary process for forming a grafted copolymer of cellulose acetate (CA) with sulfonated acrylamido methyl propane (AMPS) and methyl methacrylate (MMA).

FIG. 401B Chemical comparison between a homo-ionomeric IEM comprising P(MMA-co-AMPS) grafted to sulphonated cellulose acetate (sCA) versus a co-ionomeric dual-acid IEM where P(MMA-co-AMPS) is grafted onto phosphorylated cellulose acetate (pCA).

FIG. 402. Summary of exemplary inventive elements in fabricated ion exchange membrane including support skeleton; biopolymers of chitosan (CS), cellulose (CE), cellulose acetate (CA), alginic acid (AA), and variants thereof; including sulfonated and phosphorylated functional groups forming an ionomeric membrane, a pillar link bridging membrane to endoskeleton, and pores created by sacrificial fillers. Chitosan copolymers and grafts include polyacrylonitrile PAN, polystyrene (PS), polyvinyl alcohol (PVA), perfluorinated sulfonic acid (PFSA), vinylpyridine (PVP), polydopamine (PDA), polydopamine-co-(3-(3-aminopropyl) dimethyl-ammonium) propane-1-sulfonate (PDA-co-AMPS). Exemplary cellulose grafts include cellulose acetate-g-methyl methacrylate-co-2-acrylamido-2-methyl propane sulfonic acid (CA-g-P(MMA-co-AMPS). Permanent fillers and dopants include sulfonated or phosphorylated graphene oxide (sGO, pGO), chitosan grafted styrenesulfonic acid coated carbon nanotubes (CS-g-SSA-CNT), protic ionic liquids (PIL), polydopamine-co-ADPS-sulfonic acid nanochains (PDA-co-ADPS-SA NCs) and polyoctahedral silsesquioxanes (POSS). Biopolymer chain cross linkers include POSS, glutaraldehyde (GA), sulfonic acid (SA), and phosphoric acid (PA).

FIG. 403A. Synthesis of imidazolium ionic salt comprising 1-butyl-3-methyl-imidazolium chloride BMImCl.

FIG. 403B. Steps for converting an ionic salt into an ionic liquid comprising the IL cation [1-butyl-3-methylimidazolium]+ abbreviated [BMIm]⁺ and the IL anion [hexafluorophosphate]⁻ abbreviated [PF₆]⁻.

FIG. 403C. Methods of synthesis of secondary ionic liquids using acid-base neutralization and metal metathesis reactions.

FIG. 404A. Schematic cross sectional representation of proton exchange membrane comprising catalyst layers, polymer backbone, ionomers and ionic charge and reactants.

FIG. 404B. Schematic cross sectional representation of proton exchange membrane depicting structure with ionized protons and water but neglecting hydronium ions.

FIG. 404C. Schematic depiction of ionomer-to-ionomer hopping conduction in proton exchange membrane.

FIG. 405A. Schematic cross sectional representation of proton exchange membrane comprising catalyst layers, polymer backbone, ionomers, ionic charge and reactants including ionic liquid doped cations and anions.

FIG. 405B. Schematic depiction of hopping conduction mechanisms in ionic liquid doped proton exchange membrane including ionomer-to-ionomer, IL cation-to-cation, and ionomer-to-IL cation charge transport.

FIG. 406A. Chemical representations of exemplary ionic liquid cations comprising imidazolium, pyrrolidinium, and pyridinium radicals.

FIG. 406B. Chemical representation of other exemplary ionic liquid cations comprising ammonium, quaternary ammonium, and phosphonium radicals.

FIG. 406C. Chemical representation of other exemplary ionic liquid cations comprising sulfonium, thiazolium, and piperidinium radicals.

FIG. 406D. Chemical representation of other exemplary ionic liquid cations comprising alkanium, cholinium, and poly n-vinylimidazolium.

FIG. 407. Phase diagram representing the meting temperature of an ionic salt as a function of IL anion molar fraction.

FIG. 408. Exemplary anions present in ionic liquids.

FIG. 409A. Representative isomers and variants of imidazole and associated ionic liquids containing imidazolium cations.

FIG. 409B. Generalized scalable representation of 1-alkyl-3-methylimidazolium cations along with ethyl (n=2) and propyl (n=3) variants thereof.

FIG. 409C. Butyl (n=4), hexyl (n=6), and octyl (n=8) variants of 1-alkyl-3-methylimidazolium cations.

FIG. 410. Graph illustrating the dependence of the dissociation temperature T_{d} of 1-alkyl-3-methylimidazolium ionic salts on alkyl chain length ‘n’.

FIG. 411A. Representative isomers and variants of pyrrolidine and associated ionic liquids containing pyrrolidinium cations including generalized scalable N-alkyl-N-methylpyrrolidinium.

FIG. 411B. Ethyl (n=1), methyl (n=2), and propyl (n=3) variants of N-alkyl-N-methylpyrrolidinium.

FIG. 411C. Isopropyl (n=3), butyl (n=4), and pentyl (n=5) variants of N-alkyl-N-methylpyrrolidinium

FIG. 412A. Representative isomers and variants of pyridine and associated ionic liquids containing pyridinium cations including generalized scalable alkylpyridinium.

FIG. 412B. Ethyl (n=1), methyl (n=2), and propyl (n=3) variants of alkylpyridinium cations.

FIG. 412C. Butyl (n=4), hexyl (n=6), and octyl (n=8) variants of alkylpyridinium cations.

FIG. 413A. Representative isomers and variants of ammonia and associated ionic liquids containing ammonium and primary substituted ammonium cations.

FIG. 413B. Representative moieties of secondary, tertiary, and quaternary substituted ammonium cations.

FIG. 413C. Methyl (n=2) variants of alkylpyridinium cations.

FIG. 413D. Generalized scalable N-tetraalkylammonium cation along with tetramethyl and tetraethyl moieties.

FIG. 413E. Tetrapropyl, tetrabutyl, and tetrahexyl moieties of ammonium cations.

FIG. 413F. Phenyl moieties of ammonium cations including tetraphenyl, phenyltrimethyl, and benzyltriethyl variants.

FIG. 413G. Phenyl moieties of ammonium cations including benzyltripropyl, benzyltributyl, and triethylmethyl variants.

FIG. 413H. Long-chain alkyl moieties of ammonium cations comprising dioctyldimethyl and dodecylethyldimethyl variants.

FIG. 413I. Long-chain alkyl moieties of ammonium cations comprising benzyldimethylstearyl and trimethylstearyl variants.

FIG. 413J. Moieties of ammonium cations comprising tetra(4-thiaalkyl) and hydroxyl variants.

FIG. 413K. Moieties of ammonium cations comprising triethanolammonium, N-oxoammonium, and aminoxl oxoammonium variants.

FIG. 414A. Representative isomers and variants of phosphine and associated ionic liquids containing phosphonium and primary-substituted methylphosphonium cations.

FIG. 414B. Representative moieties of secondary, tertiary, and quaternary substituted methylphosphonium cations along with a generalized scalable alkylphosphonium cation.

FIG. 414C. Moieties of phosphonium cations comprising methoxymethyltriphenyl, ethyltriphenyl, and butyltriethyl variants.

FIG. 414D. Moieties of phosphonium cations comprising butyldiethylmethyl, methylethylbiphenyl, and tetrakis(hydroxymethyl) variants.

FIG. 415A. Representative isomers and variants of sulfide and associated ionic liquids containing sulfonium cations including nascent, primary, secondary, and tertiary substituted variants.

FIG. 415B. Representative moieties of primary, secondary, and tertiary methyl substituted sulfonium cations.

FIG. 415C. Generalized scalable alkylsulfonium cation including alkyl, dialkyl, and trialkyl variants.

FIG. 415D. Moieties of sulfonium cations comprising tris(dimethylamino), triphenylsulfonium, and diphenylmethyl variants.

FIG. 415E. Moieties of sulfonium cations comprising diethylmethyl, triethyl, and diethylpropyl variants.

FIG. 416A. Representative isomers and variants of thiazole and associated ionic liquids containing thiazolium cations including quad-radical, mono-radical basic, and mono-alkyl or dialkyl functional groups.

FIG. 416B. Moieties of thiazolium cations comprising mono-radical hydroxyethyl, tri-radical ethyl-hydroxyethyl-methyl, tri-radical benzyl-hydroxyethyl-methyl, and dimethylnaphtho variants.

FIG. 416C. Moieties of thiazolium cations comprising mono-radical benzothiazolium, di-radical dimethyl benzothiazolium, di-radical ethyl-methyl benzothiazolium, and phenacylthiazolium.

FIG. 417A. Representative isomers and variants of piperidine and associated ionic liquids containing piperidinium cations including monovalent moieties comprising two functional groups of hydrogen, two functional groups of radicals R, and N-alkyl-N-methylpiperidinium.

FIG. 417B. Methyl (n=1), propyl (n=3), and butyl (n=4) variants of N-alkyl-N-methylpiperidinium.

FIG. 418A. Moieties of carbonium cations comprising methanium, protonated methanol, and ethanium.

FIG. 418B. Moieties of carbonium cations comprising protonated ethanol, butanium, and protonated acetone.

FIG. 418C. Moieties of carbonium cations comprising protonated acetonitrile, protonated dimethyl sulfoxide, and protonated aniline.

FIG. 419. The chemical structure of biochemical cations of ionic liquids comprising cholinium, creatininium, and lysinium.

FIG. 420. Exemplary superbases applicable in ionic liquids comprising enium, phosphazene, and cyclopropenium cations.

FIG. 421. Exemplary cations of polymer ionic liquids (PILs) comprising variants of vinyl pyrrolidinium.

FIG. 422A. Fabrication sequence for forming ion exchange membranes with micropores using sacrificial fillers.

FIG. 422B. Process steps for doping microporous membranes with ionic liquid.

FIG. 422C. Ionic liquid doped microporous ion exchange membrane sealed by nanocoating.

FIG. 423. Exemplary steps in fabricating an ion exchange membrane containing permanent fillers, sacrificial filler formed micropores, ionic liquid doping, and nanocoating sealant.

FIG. 424. Process sequence for forming a nanocoated IL-doped microporous IEM with embedded permanent fillers.

FIG. 425. Comparison of IL-doping of conventional IEMs to endoskeletal reinforced membranes using a pancake versus waffle analogy.

FIG. 426. A topological summary of various types of block polymers.

FIG. 427A. Process to form a block polymer using a excision-insertion reaction.

FIG. 427B. Process to form a block polymer using a modified ring opening polymerization.

FIG. 427C. Process to form a block polymer using a nucleophilic aromatic substitution reaction.

FIG. 427D. Process to form a block polymer using atomic transfer radical polymerization.

FIG. 427E. Process to form a block polymer using cross-linker polymerization.

FIG. 428A. Chemical structure and block map of a sulfonated styrene penta-block copolymer.

FIG. 428B. Chemical structure and block map of a sulfonated styrene quad block copolymer.

FIG. 428C. Chemical structure and block map of a sulfonated phenyl mirrored quad block copolymer.

FIG. 428D. Chemical structure and block map of sulfonated arylene ether sulfone alternating di-block copolymers.

FIG. 428E. Chemical structure and block map of sulfonated arylene ether sulfone random multi-block copolymers.

FIG. 428F. Chemical structure and block map of a sulfonated polystyrene branched multi-block copolymer.

FIG. 428G. Chemical structure and block map of a sulfonated poly(phenylene oxide) branched multi-block copolymer.

FIG. 428H. Chemical structure and block map of a sulfonated polytriazole sidechain in a comb multi-block copolymer.

FIG. 428I. Chemical structure and block map of a R functionalized polysulfone sidechain block copolymer.

FIG. 428J. Chemical structure and block map of a poly(sulfide ketone) sulfonated hexaphenyl tri-block copolymer.

FIG. 428K. Chemical structure and block map of a poly(ether sulfone) decaphenyl sulfonic acid alternating block copolymer.

FIG. 428L. Chemical structure and block map of a sulfonated polyphenyl sidechain tri-block copolymer.

FIG. 429A. Quasi-3D representation of an semi-amorphous ionomeric film comprising two copolymers structurally bound by supportive endoskeletal pillars, where the pillars contain carbon filler or other reinforcing materials.

FIG. 429B. Schematic representation comparing homopolymers and copolymers containing homo-ionomers and hetero-ionomers.

FIG. 429C. Quasi-3D representation of individual ionomeric strands comprising an ionomeric film and an exemplary amorphous polymer matrix resulting therefrom.

FIG. 429D. Quasi-3D representation of a ionomeric film comprising two copolymers structurally bound to surrounding endoskeletal pillars, where naturally-occurring pores are present interstitially within a semi-amorphous polymer matrix.

FIG. 429E. Simplified quasi-3D representation of a semi-amorphous ionomeric film comprising two copolymers structurally bound by endoskeletal pillars illustrating naturally occurring pores. For clarity's sake the polymer strands and pillar fillers are not shown.

FIG. 429F. Simplified quasi-3D representation of a ionomeric film comprising a semi-amorphous ionomeric film comprising two copolymers structurally bound to endoskeletal pillars, where the membrane contains both naturally-occurring interstitial pores along with sac pores made by sacrificial fillers. For clarity's sake the polymer strands and pillar fillers are not shown.

FIG. 429G. Quasi-3D representation of a densely-packed ionomeric film comprising a semicrystalline homopolymer and associated endoskeletal pillars illustrating small nanopores present interstitially within the polymer matrix.

FIG. 429H. Simplified quasi-3D representation of a dense ionomeric film comprising a semicrystalline homopolymer highlighting naturally occurring nanopores present interstitially withing the matrix. For clarity's sake the polymer strands and pillar fillers are not shown.

FIG. 429I. Simplified quasi-3D representation of a dense ionomeric film comprising a semicrystalline homopolymer with supporting endoskeletal pillars, where the membrane includes naturally-occurring nanopores along with larger sac pores made by sacrificial fillers. For clarity's sake the polymer strands and pillar fillers are not shown.

FIG. 429J. Simplified quasi-3D representation of a semi-amorphous membrane with supporting endoskeletal pillars illustrating a combination of naturally-occurring interstitial pores combined with permanent fillers where the average filler size is larger than the naturally occurring pores. For clarity's sake the polymer strands and pillar fillers are not shown.

FIG. 429K. Simplified quasi-3D representation of a semi-amorphous membrane with supporting endoskeletal pillars illustrating a combination of naturally occurring pores combined with sac pores made by sacrificial fillers and with permanent fillers where the average filler size is larger than the naturally occurring and sacrificial pores. For clarity's sake the polymer strands and pillar fillers are not shown.

FIG. 429L. Simplified quasi-3D representation of a semi-amorphous membrane comprising a homopolymer or two-or-more copolymers with supporting endoskeletal pillars illustrating a combination of naturally-occurring interstitial pores combined with sac pores made by sacrificial fillers and with small permanent fillers or dopants present in matrix where the average filler size is smaller than the naturally-occurring and sacrificial pores. For clarity's sake the polymer strands and pillar fillers are not shown.

FIG. 429M. Simplified quasi 3D representation semi-amorphous membrane comprising a homopolymer or two-or-more copolymers with supporting endoskeletal pillars illustrating the combination of naturally-occurring pores and sac pores made by sacrificial fillers combined doped with ionic liquids. As depicted the ionic liquid present interstitially throughout the membrane pools in greater concentrations with natural and sac pores.

FIG. 430. An exemplary summary of various versions of ionomeric polymer membranes made in accordance with this invention including an exemplary list of ionomer types made of homopolymers, fluorocarbon di-monomers, hydrocarbon di-monomers, hydrocarbon multi-polymers, hydrocarbon heteropolymers, hydrocarbon copolymers, anhydrous polymers and biopolymers, and block polymers.

FIG. 431A. Exemplary chemical representations of hydrocarbon homopolymers made in accordance with this invention including sulfonated polyphenylene, sulfonated phenyl-aldehyde, sulfonated covalent triazine polymer, and phosphorylated polyvinyl alcohol.

FIG. 431B. Other exemplary chemical representations of hydrocarbon homopolymers made in accordance with this invention including polystyrene-sulfonated polystyrene, sulfonated polysulfone, sidechain sulfonated poly(benzoyl-phenylene), and linear sulfonated poly(trifluorostyrene).

FIG. 431C. Exemplary chemical representations of hydrocarbon ionomers made in accordance with this invention including the homopolymer poly(ether imide) and a linear copolymer of sulphonated poly(arylene ether sulfone) triazine bisphenol moieties.

FIG. 431D. Exemplary chemical representations of fluorocarbon ionomers comprising linearly-arranged heterogenous di-monomers made in accordance with this invention including a compound reinforced membrane of perfluorinated sulfonic acid polytetrafluoroethylene, poly(perfluoro-methylene-methyl-dioxolane), sulfonated fluorinated glassy matrices, and perfluoro imide acid.

FIG. 431E. Exemplary chemical representations of hydrocarbon copolymers comprising linearly-arranged heterogenous di-monomers made in accordance with this invention including maleic anhydride poly(methyl methacrylate) (MAH-PMMA), sulfonated polyethylene, sulfonated polyvinyl chloride, and sulfonated phenylsulfonyl-poly(benzoyl-phenylene).

FIG. 431F. Exemplary chemical representations of hydrocarbon copolymers comprising heterogenous di-monomers made in accordance with this invention including linearly-arranged poly sulfonated phosphazene-co-poly phosphazene and poly sulfonated siloxane-co-siloxane, along with cross-linked sulfonated polystyrene.

FIG. 431G. Exemplary chemical representations of linearly-arranged heterogenous hydrocarbon copolymers made in accordance with this invention including sulfonated polyimide and sulfonated poly(fluorenyl ether ketone nitrile).

FIG. 431H. Exemplary chemical representations of linearly-arranged heterogenous hydrocarbon-fluorocarbon blended copolymers made in accordance with this invention including sulfonated fluorinated polyethersulfone and sulfonated poly(arylene ether sulfone).

FIG. 431I. Exemplary chemical representations of heterogenous hydrocarbon copolymers made in accordance with this invention comprising linearly arranged poly arylene ether (sP6F9CB) and the comb copolymer thermoplastic urethane-co-sulfonated divinyl benzene.

FIG. 431J. Exemplary chemical representations of linearly-arranged heterogenous fluorocarbon copolymers made in accordance with this invention including perfluoro-methylene-methyl-dioxolane-co-perfluoro-methylene-dioxolane, perfluoro-methylene-methyl-dioxolane-co-chlorotrifluoroethylene, perfluoro-methylene-methyl-dioxolane-SA-co-perfluorostyrene, and poly(dioxodihydropyrrole-co-carbonyl sulfonyl fluoride-co-styrene-SA.

FIG. 431K. Exemplary chemical representations of linearly-arranged heterogenous hydrocarbon copolymers made in accordance with this invention including sulfonated polyphenylene-co-quaterphenol and sulfonated polyamide-co-sulfonimide.

FIG. 431L. Exemplary chemical representations of heterogenous hydrocarbon copolymers made in accordance with this invention including cross-linked sulfonated polyvinyl alcohol, polyvinylidene fluoride-co-sulfonated polyvinyl alcohol; and hydrocarbon-fluorocarbon blended multi-polymer polyvinylidene fluoride-co-perfluorosulfonic acid.

FIG. 431M. Exemplary chemical representations of heterogenous hydrocarbon multipolymers made in accordance with this invention including sulfonated poly(ether ketone) and sulfonated poly(ether sulfone) sequenced linear copolymers sPEₓK_{y} and sPEₓ(Sf)_{z} respectively.

FIG. 431N. Exemplary chemical representations of heterogenous hydrocarbon multipolymers made in accordance with this invention including sulfonated poly(ketone sulfone) and sulfonated poly(arylene ether ketone sulfone) sequenced linear copolymers sP(K_{y}(Sf)_{z}) and sP(A_{w}EₓK_{y}(Sf)_{z}) respectively. In both exemplary moieties, only the ketone group is sulphonated.

FIG. 431O. Exemplary chemical representations of heterogenous hydrocarbon multipolymers made in accordance with this invention including polyvinyl difluoride-co-polyvinyl pyrrolidone-co-polystyrene sulfonic acid (SA) and polyvinylidene fluoride-co-polyvinylidene pyrrolidone SA.

FIG. 431P. Exemplary chemical representations of heterogenous hydrocarbon multipolymers made in accordance with this invention including tri-polymer polyvinylidene fluoride-co-azobisiso butyronitrile-co-sulfopropyl acrylate, bi-polymer polyvinylidene fluoride-co-hexafluoro propylene, and quarte-polymer polyvinylidene fluoride-co-azobisiso butyronitrile-co-sulfopropyl acrylate-co-hexafluoropropylene.

FIG. 431Q. Exemplary chemical representations of heterogenous fluorocarbon multi-polymers made in accordance with this invention including graft poly(perfluoroalkoxy alkane)-g-polystyrene sulfonic acid, and cross linked copolymer chains of sulfonated poly(trifluorostyrene).

FIG. 431R. Exemplary chemical representations of membranes made in accordance with this invention including heterogenous biopolymers of poly(dopamine-sulfonated dopamine) and D-glucosamine SA based sulfonated chitosan; along with anhydrous polymers comprising variants of sulfonated poly phenylene bibenzimidazole.

FIG. 432A. Proton exchange membrane attached homo-ionomers made in accordance with this invention comprising negatively charged anions of acids, hydroxides, and amide groups.

FIG. 432B. Additional proton exchange membrane-attached homo-ionomers made in accordance with this invention comprising negatively charged anions of acids and phosphates.

FIG. 432C. Proton exchange membrane attached ionomers hetero-ionomers made in accordance with this invention comprising acid and hydroxide combinations.

FIG. 432D. Proton exchange membrane attached ionomers hetero-ionomers made in accordance with this invention comprising acid and phosphate combinations.

FIG. 432E. Response curves showing superposition of co-ionomer characteristics.

FIG. 433A. Chemical and structural representations of permanent IEM fillers and dopants made in accordance with this invention including bismuth compounds, graphene oxides, carbon nanotubes including pristine, nanocoated, or functionalized variants. CNT surface treatments comprise amino, silica, titania, hydroxy-phosphoric, carboxyl, and acid groups such as sulfonic acid.

FIG. 433B. Chemical and structural representations of other permanent IEM fillers and dopants made in accordance with this invention including silicates, nano structures and particles, zirconium, metal organic frameworks (MOF), tungsten, zeolite, and polyoctahedral silsesquioxanes compounds.

FIG. 433C. Cations of various ionic liquids made in accordance with this invention.

FIG. 434A. Simplified block diagram of a static array buffered fuel cell.

FIG. 434B. Simplified block diagram of a dynamic array buffered fuel cell with buffer load access output port protection.

FIG. 434C. Simplified block diagram of a dynamic array buffered fuel cell with buffer load access output port protection and electrical power input via energy recovery modulation.

FIG. 435. Energy input and outputs in iBFC applications.

FIG. 436. Schematic of iBFC electrical elements including fuel cell stack, electrical buffer, charger, and load protection.

FIG. 437A. BLA buffer load access bidirectional blocking switch implementation comprising four terminal lateral MOSFET with body bias generator.

FIG. 437B. BLA buffer load access bidirectional blocking switch implementation comprising common source and common drain trench power DMOSFETs.

FIG. 438. Improved BLA buffer load access comprising a three power MOSFET implementation of bidirectional disconnect and bypass switch functions.

FIG. 439. Block diagram of iBFC intelligent buffered fuel cell modules and functions.

FIG. 440. Power loss in resistive devices as a function of input power from a 4V, 24V and 48V source.

FIG. 441. Schematic of a 24V iBFC comprising a dynamic fuel cell array with buffer cell balancing.

FIG. 442. Fuel cell stack voltage as a function of individual fuel cell V_{FC} comprising stacks with n=21, n=42,or n=63.

FIG. 443. iBFC operation of a dynamic fuel cell switching between n=63 and n=42 including hysteresis.

FIG. 444. Top view of exemplary 24V iBFC including three stacks of 21 PEM+fuel cells.

FIG. 445. End view of exemplary 24V iBFC comprising three stacks of 21 PEM+fuel cells.

FIG. 446. Cutline view of 6s1p buffer cells within exemplary 24V iBFC.

FIG. 447. Perspective view of 6s3p buffer cells in exemplary 24V iBFC module.

FIG. 448. Exterior view of exemplary 24V iBFC.

FIG. 449. Schematic of 4 μstack 24V iBFC module.

FIG. 450. Voltage-current transfer characteristics of a dual-mode dynamic buffered fuel cell.

FIG. 451. FC stack voltage dependence on individual membrane voltages VFC as function of stack height n_{FC}.

FIG. 452. Schematic comparison of two-zone and three-zone five-μstack buffered fuel cells.

FIG. 453. Voltage-current transfer characteristics of a dual-mode dynamic buffered fuel cell comparing n_{FC}={36, 60}.

FIG. 454. Voltage-current transfer characteristics of a three-mode dynamic buffered fuel cell comparing n_{FC}={36, 48, 60}.

FIG. 455. Components of a buffered fuel cell including charge transfer regulator driving a summing node, with a charge transfer regulator limiting the buffer voltage balanced across cells.

FIG. 456. Details of a charge transfer regulator in a buffered fuel cell driving a shared summing node.

FIG. 457. Details of a charge transfer regulator in a buffered fuel cell lacking a shared summing node.

FIG. 458. I-V characteristics of constant current charger and antiparallel current source bypass circuit.

FIG. 459. Calibration of BFC lumped element model.

FIG. 460. Schematic representation of various buffered fuel cells with a constant cell voltage V_{FC}=0.7V.

FIG. 461. Stack voltages for various buffered fuel cells contrasting n_{FC}=(36, 48, 601 as a function of fuel cell membrane voltage V_{FC}.

FIG. 462. Schematic representation of various buffered fuel cells with a constant output voltage V_{L}=25.2V.

FIG. 463. Scalable energy bank power architecture comprising a mainframe delivering hydrogen, oxygen, cooling, and power bussing to pluggable energy blades. In the example shown the energy blades generate 5 kW to 7 kW of power-on-demand, i.e. power for one hour at a 1 C rate, plus continuous power ranging from 1 kW to 4 kW available perpetually so long that hydrogen is suppled.

FIG. 464. Cross section of a μstack fuel cell with gas supply routed through a temperature regulated backplate. Although a hydrogen gas circuit is shown, the backplate may also include oxygen or air supply, plus liquid cooling as required.

FIG. 465. Cross section illustrating the physical connection between a μstack fuel cell and non-planar electrically-insulating thermally conductive backplate including gas transfer and requisite grommets to prevent hydrogen leakage.

FIG. 466A. Cross sectional representation of the starting material used for forming power blade backplates.

FIG. 466B. Cross sectional representation of the power blade backplate substrate after channel formation.

FIG. 466C. Cross sectional representation of the power blade backplate substrate illustrating the process step attaching insulating PCB comprising a single- or double-sided board attached to the thermally conductive substrate.

FIG. 466D. Cross sectional representation of the power blade backplate substrate illustrating an insulating PCB comprising a single- or double-sided board attached to the thermally conductive substrate with selective vias.

FIG. 466D. Cross sectional representation of the power blade backplate attached to printed circuit board illustrating both ports and buried gas conduits.

FIG. 466E. Cross sectional representation of the power blade backplate attached to printed circuit board illustrating both ports and buried gas conduits and including non-planar copper conductive traces.

FIG. 467. Cross sectional representation of the power blade backplate attached to printed circuit board illustrating the role of a grommet to prevent gas leakage.

FIG. 468A. Cross sectional representation of the power blade backplate attached to printed circuit board illustrating both ports and buried gas conduits and including coplanar copper conductive traces.

FIG. 468B. Cross sectional representation of the power blade backplate with printed circuit board, buried gas conduits, coplanar copper conductive traces directly bonded to μstack fuel cell assembly.

FIG. 469. Cross sectional representation of a μstack fuel cell assembly illustrating gas transport from and back into a planarized backplate.

FIG. 470. Cross sectional representation of a backplate containing a cooling coil for uniform temperature regulation of a PCB and attached μstack fuel cell modules. A thermally conductive backplate core is excluded from the illustration.

FIG. 471. Graph comparing the time dependent current characteristics I_{FC}(t) of a battery pack versus the inventive buffered fuel cell in three operating modes—transient, 1 C power-on-demand, and continuous operation where the number of cells for the battery pack and iBFC are equal. Note that batteries are incapable of continuous power delivery, but can only deliver PoD power for one hour at a IC discharge rate, after which current drops to zero. The buffered fuel cell deliver a higher average power during 1 C PoD discharge but after continues to deliver a steady state current indefinitely.

FIG. 472A. Plan view of an embodiment of a iBFC power blade comprising twelve 200 cm² μstack fuel cells and 96 buffer cells fit into a standard power blade dimension of 48.3 cm (19 in) wide and 76 cm (30 in) deep. The power blade delivers 5.2 kW of power-on-demand but a continuous power of 4 kW with a steady-state to on-demand P_{SS}-to-PoD power ratio of 77%.

FIG. 472B. Plan view of an embodiment of a iBFC power blade comprising seven 200 cm² μstack fuel cells and 294 buffer cells fit into standardized power blade dimensions. The power blade delivers 6.0 kW of power-on-demand but a continuous power of 2.5 kW with a steady-state to on-demand P_{SS}-to-PoD power ratio of 42%.

FIG. 472C. Plan view of an alternative embodiment of a BFC power blade comprising seven 200 cm² μstack fuel cells and 210 buffer cells fit into standardized power blade dimensions. For ease of comparison, the components are not repositioned on the PCB to benefit from the unused space. The power blade delivers 5.0 kW of power-on-demand but a continuous power of 2.5 kW with a steady-state to on-demand P_{SS}-to-PoD power ratio of 50%.

FIG. 472D. Plan view of an embodiment of a iBFC power blade comprising six 200 cm² μstack fuel cells and 300 buffer cells fit into standardized power blade dimensions. For ease of comparison, the components are not repositioned on the PCB to benefit from the unused space. The power blade delivers 5.7 kW of power-on-demand but a continuous power of 2.0 kW with a steady-state to on-demand P_{SS}-to-PoD power ratio of 35%.

FIG. 472E. Plan view of an alternative embodiment of a iBFC power blade comprising six 200 cm² μstack fuel cells and 240 buffer cells fit into standardized power blade dimensions. For ease of comparison, the components are not repositioned on the PCB to benefit from the unused space. The fuel cells and buffer cell may configured in two topologies offering qual power outputs offering either double the iBFC current of double the iBFC voltage of the other version. Regardless of its serial or parallel cell topology, either power blade delivers 5.0 kW of power-on-demand with a continuous power of 2.0 kW with a steady-state to on-demand P_{SS}-to-PoD power ratio of 40%.

FIG. 472F. Plan view of an embodiment of a iBFC power blade comprising five 200 cm² μstack fuel cells and 280 buffer cells fit into standardized power blade dimensions. For ease of comparison, the components are not repositioned on the PCB to benefit from the unused space. The power blade delivers 5.2 kW of power-on-demand but a continuous power of 1.7 kW with a steady-state to on-demand P_{SS}-to-PoD power ratio of 33%.

FIG. 472G. Plan view of an embodiment of a iBFC power blade comprising four 200 cm² μstack fuel cells and 296 buffer cells fit into standardized power blade dimensions. For ease of comparison, the components are not repositioned on the PCB to benefit from the unused space. The power blade delivers 5.0 kW of power-on-demand but a continuous power of 1.4 kW with a steady-state to on-demand P_{SS}-to-PoD power ratio of 28%.

FIG. 472H. Plan view of an embodiment of a iBFC power blade comprising three 200 cm² μstack fuel cells and 480 buffer cells fit into standardized power blade dimensions, where the design occupies virtually the entire available PCB area. The battery heavy power blade delivers 7.0 kW of power-on-demand but a continuous power of 1.0 kW with a steady-state to on-demand P_{SS}-to-PoD power ratio of 14%.

FIG. 472I. Plan view of an embodiment of a iBFC power blade comprising three 200 cm² μstack fuel cells and 336 buffer cells fit into standardized power blade dimensions. For ease of comparison, the components are not repositioned on the PCB to benefit from the unused space. The power blade delivers 5.2 kW of power-on-demand but a continuous power of 1.0 kW with a steady-state to on-demand P_{SS}-to-PoD power ratio of 19%.

FIG. 473A. Graph of power output separately identifying buffer power P_{buf}, steady-state fuel cell power P_{SS}=P_{FC}, and power-on-demand P_{PoD}=P_{SS}+P_{buf}, for a spectrum of fuel cells comprising a power blade using a 3000 cm² PCB, fractionally divided by competing areas of buffer cells A_{buf} and fuel cells A_{FC}.

FIG. 473B. Graph of power-on-demand P_{PoD} for an iBFC power blade as a function of total buffer area A_{buf} as a fraction of a PCB area A_{pcb}=3000 cm².

FIG. 473C. Graph of power-on-demand P_{PoD} for an iBFC power blade as a function of total fuel cell area A_{FCf} as a fraction of a PCB area A_{pcb}=3000 cm².

FIG. 473D. Graph of the continuous output power P_{SS} of an iBFC power blade of total PCB area A_{pcb}=3000 cm² as a function of output power-on-demand P_{P}OD.

FIG. 473D. Graph of constituent power outputs of a 3000 cm² iBFC power blade, including steady-state power P_{SS}, power-on demand P_{PoD}, and 10 second transient power P₁₀ₛ as a function of the number of buffer cells #buf. Calculations assume all board area not occupied by buffer cells contains fuel cell area.

FIG. 473D. Graph of constituent power outputs of a 3000 cm² iBFC power blade, including steady-state power P_{SS}, power-on demand P_{PoD}, and 10 second transient power P₁₀ₛ as a function of the number of buffer cells #buf highlighting the none previously described iBFC designs.

FIG. 474. Hydrogen power system architecture comprising both a intelligent buffered water to hydrogen converter (iBH2WC) electrolyzer and a separate intelligent buffered fuel cell (iBFC) each with their own dedicated buffer cell array.

FIG. 475. Hydrogen power system architecture comprising both a unbuffered water to hydrogen converter (iBH2WC) electrolyzer powered by an intelligent buffered fuel cell (iBFC).

FIG. 476. Circuit illustrating a buffer water to hydrogen converter and electrolyzer.

FIG. 477. Circuit illustrating a unbuffered water to hydrogen converter and electrolyzer power by the buffer cells in the iBFC.

FIG. 478. Brief overview of inventive features in an advanced fuel cell with PEM+ membrane.

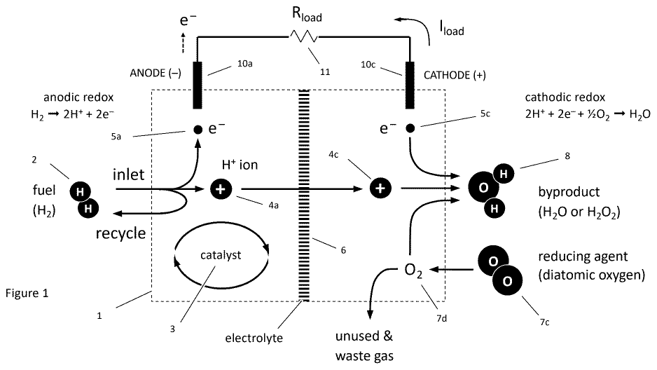

### DESCRIPTION OF INVENTION

A new class of ion exchange membrane membranes is described created to ameliorate or eliminate the various deficiencies present in present day conventional fuel cells. Specifically this patent discusses innovations in proton exchange membranes (PEMs), also known a cation ion exchange membrane (CEMs), or hydrogen ion exchange membranes (H⁺ IEMs). Topics discussed include
IEM structural support for improved handling and operational reliability
Proton exchange membrane (PEM) for hydrogen fuel cell operation
Proton exchange membrane (PEM) for hydrogen from water hydrolysis
Proton exchange membranes for alternative uses, including filtering and dialysis
Hydrogen ion exchange membranes for alternative uses
Applications of improved IEMs

Specifically this patent concentrates on the improved implementation of proton ion exchange membranes using hydrogen as a fuel source as reflected in its title “Advanced Hydrogen Ion Exchange Membranes and Applications Thereof.” The various embodiments of inventions described and disclosed herein can be implemented individually or in combination.

Although the focus of this discussion is on membranes transporting cations comprising ionized hydrogen, i.e. protons, its should be understood the principles, methods, fabrication techniques, and applications of such hydrogen based IEM fuel cells and electrolyzers are not strictly limited to such narrowly defined topics, but may be applied to other types of fuel cells and electrolysis such as those employing methanol, methane, glucose or where ion transport across the membrane involves negatively charged anions.

Alternative IEMs and related innovations involving anion exchange membranes (AEMs) for fuel cells and hydrolysis; ion exchange membranes for glucose based fuel cells and electrolysis (Glu-IEMs), and ion exchange membranes (IEMs) for electrolysis of carbon compounds are explicitly considered in this application, but numerous inventive elements such as endoskeletal support apply.

### Basic IEM Terminology.

Herewith, the use of the terms cation, proton, and hydrogen ion as the H⁺ or the hydronium ion H₃O⁺ will be used interchangeably unless explicitly being described in comparative terms. For clarification, in the lexicon of ion exchange membranes please refer to the Glossary of Terms section of this application. As defined herein, it will be understood that protons, i.e. ionized hydrogen, represent a specific subset of cations, which in turn together with anions are a subset of all ions. It should also be mentioned that the ionized state of matter is not a stable condition. In nature ions spontaneously revert to stable elements over time, the very reason an unused battery self discharges.

One advantage of a hydrogen fuel cell compared to other forms of energy is its fuel comprises stable elemental hydrogen atoms without toxic compounds. In operation, the hydrogen atoms are stripped of their electrons at the time of use resulting in hydrogen ions H⁺, i.e. protons are created ‘just-in-time’ to be used. To accelerate the ionization process the fuel cell employs a catalyst. A ‘catalyst’ is substance that increases the rate of a chemical reaction without itself undergoing any permanent chemical change. Common hydrogen catalysts include platinum and palladium. As numerous embodiments of this invention, the composition of the catalyst layer may include additives and permanent fillers added to enhance catalytic turnover rates (TORs), reduce interfacial contact resistance, and to prevent poisoning of the CL. Once the hydrogen is ionized the resulting protons traverse the ion exchange membrane from the anode to the cathode.

Positive charge transport within the IEM occurs by two mechanisms—charge hopping and vehicular transport, with conduction involving two physical forms of propulsion namely drift conduction in response to electrostatic forces, and diffusion, a statistical mechanical mechanism involving the random vibration of atoms. All four combinations occur in a conducting ion exchange membrane but in varying degrees, specifically charge hopping driven by diffusion, charge hopping electrostatically driven by drift conduction, vehicular transport of ions driven by diffusion, and vehicular transport of ions electrostatically driven by drift conduction.

The relative contribution of these four conduction components depends on the manufacture and composition of an ion exchange membrane, the influence of ambient conditions such as temperature and relative humidity, and the current density flowing across the membrane. In various embodiments of this invention, these relative contributions are decided by IEM design and processing by controlling the ionomer concentration within the polymer and by controlling the crystallinity and porosity of the polymer's molecular matrix.

In the vernacular of ion exchange membranes, ‘charge hopping’ aka Grotthuss conduction is the mechanism where protons repeatedly jump to negatively-charged immobile ionized molecules called ionomers, hopping from one ionomer to the next. Since the ionomers in a PEM are negatively ionized immobile anions, only positive charged cations can traverse the matrix. The driving force of protonic charge hopping comprises both diffusion, current conduction resulting from a concentration gradient; and from electric drift, the electrostatic force experienced by charge responding to an electric field.

Charge hopping can occur in any atomic matrix containing ionomers, i.e. immobile ionized groups. In a PEM membrane, these ionomers comprise membrane-bound acids that ionize into immobile anions. Because protons can hop between the adjacent anions, hopping conduction does not require pores and channels in the atomic matrix for conduction to occur. As such, hopping conduction is one-dimensional with protons flowing in a relatively straight line from the anode to the cathode. The magnitude of hopping current depends primarily on the ionomeric density within the matrix.

The term ‘vehicular transport’ by contrast describes the movement of ions through channels within the polymer matrix and does not rely on ions attaching and detaching themselves onto immobile ionomers within the polymer. The role of the acid groups in vehicular transport is thereby to donate protons into the matrix through ionization, not to carry current. In this regard ionic liquids can also contribute to vehicular transport but without increasing the immobile ionomeric density. In vehicular transport, free protons spontaneously attach themselves to water molecules to form hydronium ions. As hydronium ions are significantly larger than free protons, they require contiguous pores in the polymer's matrix to form conductive channels through which they move.

As such vehicular conduction is tortuous, involving significantly longer path lengths than hopping conduction. The longer path length means both the electric field and concentration gradient providing vehicular propulsion are reduced thereby reducing their relative contribution compared to charge hopping. At high current densities, water created in the oxygen reduction reaction (ORR) in the cathode catalyst layer (CCL) diffuses back into the matrix enhancing the role of vehicular transport by creating more hydronium charge carriers. In operation protons combine with water to form hydronium ions, some of which revert back into H⁺ and H₂O, creating a equilibrium condition. By contrast the density of ionomers is fixed. At high current densities they become saturated and are unable to support greater currents.

In this complex manner charge hopping and vehicular transport both contribute to conduction in an ion exchange membrane. The relative contribution of diffusion and drift propulsion in each of these conduction mechanisms depends on the proton concentration gradient, membrane hydration, and the membrane's self generated electric field. In general terms, hopping conduction plays a dominant role at low currents while vehicular transport of hydronium dominates high current conduction.

In IEM lexicology, the term ‘drift’ conduction describes current flow resulting from the electrostatic force exerted on a charge in an electric field. Drift conduction dominates charge flow in materials with an ample source of charge such as metal conductor or an ionomer carrying relatively low currents. The electric field present across the membrane is created autonomously by the accelerated ionization of hydrogen in the anode and the lack of protons persisting in the cathode together creating a perpetual charge imbalance so long that hydrogen continues to flow into the anode. While the electric field can also drive drift conduction of unbound protons in the matrix, their lifetime as free charge is limited by the presence of water interstitial to the polymer matrix.

In such cases, the hydrogen ions spontaneously bond to water forming charged hydronium ions. Like hydrogen ions, hydronium ions respond to electric fields exhibiting drift conduction. The major difference between charge hopping and vehicular transport is the conduction path—charge hopping is a bulk property where conduction is able to flow directly through the polymer matrix. Because vehicular transport is limited to circuitous paths through the matrix, the net electric field is diminished significantly reducing the importance of drift conduction in vehicular transport.

The term “diffusion’ describes the spatial reapportionment of molecules resulting from a concentration gradient. Rather than reacting to a force, diffusion is the statistical mechanical mechanism resulting from random motion whereby a concentrated bubble of ions has a greater chance of moving out of the congested region than it does heading back into the bubble. As such, both hydrogen ions and hydronium ions naturally diffuse from high concentration regions to lower concentration volumes. As long as hydrogen supply to the anode is maintained, the concentration gradient of protons ions will also persist, as such diffusion is present in charge hopping conduction. Maintaining a concentration gradient also drives diffusion based conduction via vehicular transport, especially at high currents.

Another key mechanism of fuel cell operation is the chemical reaction occurring in the cathode catalysts layer. In the cathode the incoming flux of protons and hydronium ions is countered by a preponderance of oxygen in the cathode. The oxygen combines with the protons by donating electrons, thereby reducing the cations back into uncharged hydrogen atoms. In steady state operation of a fuel cell, the rates of oxidation of hydrogen into cations in the anode and reduction of cations into hydrogen in the cathode necessarily balance in accordance with maintaining charge neutrality in the cell. Thermodynamics however dictates that the product of the coupled oxidation and reduction reactions, called a redox reaction, must have a lower energy than the fuel feeding the electrochemical cell. To satisfy this criteria, protons reduced to elemental hydrogen in the cathode necessarily combine with a reducing agent. Generally the reducing agent is either pure oxygen (100% O₂) or room air which comprises 78% non-reactive nitrogen and 21% oxygen. Care must be taken to prevent carbon monoxide or H₂O₂ from reacting with the catalyst and “poisoning” the fuel cell.

### PEM Fuel Cell Construction.

Given the emerging demand for clean and sustainable global energy applications, the need for reliable high-performance ion-exchange membranes for fuel cells is becoming increasingly evident, especially is the development of proton exchange membrane based fuel cells (PEMFCs). Unfortunately, present day PEM membranes suffer numerous deficiencies including excessive humidity dependence, low current density operation, low cell voltages, high membrane resistance and transient impedance, and an especially strong dependence of cell voltage on current. Other problems include repeated swelling and shrinkage of the membrane with water retention within the polymer leading to polymer wear out and shortened use life.

Together, these factors, further exacerbated by self-heating, humidity and ambient temperature dependence limit the conversion efficiency and electrical power density of even state-of-the art fuel cells. In particular, fuel cell voltage sag and/or voltage collapse with increasing current is especially problematic as it limits the fuel cell from directly driving a high current battery or the low-impedance input of a switching power supply needed for DC/DC voltage conversion. These problems arise for a variety of reasons including bad fuel cell design, poorly constructed membranes, inadequate process control of membrane fabrication, and lack of scalable manufacturing processes. Other factors include poor gas delivery as limited by fundamental construction deficiencies in gas diffusion layers and high interfacial contact resistances.

As described previously, a single proton-exchange membrane fuel cell generally comprises a five-layer membrane electrode assembly MEA5 sandwiched by bipolar plates BPP. The BPP is a rigid support structure in the PEMFC stack within which reactant and coolant flow occurs. The BPP is also responsible for current conduction and heat dissipation. The MEA5 comprises a gas diffusion layer (GDL) with a microporous layer (MPL) surrounding a three-layer membrane assembly or MEA3. The GDL is a layer of carbon paper or carbon cloth, which plays multiple important roles in gas distribution, mechanical support and electrical connection. Carbon layers are formed upon a substrate of carbon black and polytetrafluoroethylene (PTFE) referred to as MPL, which assists in the timely removal of electrochemically produced water. As an embodiment of this invention, these carbon layers are heterogenous of varying concentration and porosity.

The MEA3 also known as a catalyst coated membrane or CCM comprises two catalyst layers (CLs) surrounding a proton-exchange membrane (PEM). The CL is the site where the hydrogen oxidation and oxygen reduction electrochemical reactions occur, through a series of coupled physiochemical processes. Platinum-loaded carbon, which is finely dispersed to interact with the ionomer, is the most frequently used catalyst owing to its excellent activity and durability in an electrochemical environment. Aside from platinum (Pt) other platinum group metals (PGMs) include palladium (Pd), osmium (Os), rhodium (Rh), ruthenium (Ru), and iridium (Ir). PGMs are desirable for their excellent electrical conductivity and catalytic activity and for their resistance to corrosion in acidic environments consistent with proton based charge transport. Unfortunately many noble metals are notoriously expensive. Alternative catalysts made in accordance with this invention are described in a subsequent section of this application.

One especially troublesome deficiency of ion exchange membranes is their loss in structural integrity, strength, durability and rigidity as the active ionomer is thinned. While attempts have been made to integrate reinforcement throughout the membrane's active film, any increase in ionomer strength is countered by a decrease in ion conduction and lower film conductivity, reducing power efficiency and increasing membrane resistivity thereby offsetting the linear reduction in resistance gained by thinning the membrane. Lower efficiency also further exacerbates membrane heating,

One approach is to integrate PTFE into a PFSA perfluorosulfonic acid membrane to form a heterogenous reinforced composite membrane or CRM. While simple to conceptualize, hydrophilic PFSA is mutually incompatible with the highly hydrophobic nature of PTFE. The intrinsic incompatibility of hydrophilic ionomers such as PFSA coated onto a hydrophobic PTFE substrate causes film stress. These stresses are aggravated by changes in both membrane hydration and temperature during normal operation. Specifically water logging and swelling causing severe volumetric changes in the PFSA are a function of both current and relative humidity.

Elevated temperatures and temperature gradients arising from the fuel cell's exothermic reactions likewise cause stress arising from the heterogenous films exhibiting differing temperature coefficients of expansion, i.e. differential CTEs. In normal use, power levels invariably fluctuate, in turn causing repeated expansion and shrinkage in the film under wet-to-dry-to wet transitions. As such, humidity cycling, temperature cycling, and power cycling all aggravate interfacial imperfections in the composite ionomer causing creep deformation, delamination, and cracking. In particular, the formation of cracks, tears, voids, and delamination dominantly occur between the PTFE and PFSA layers, leading to an irreversible deterioration of the fuel cell performance.

Rather than relying on CRM strengthening the ionomer itself, in an embodiment of this invention the ionomer is reinforced laterally by a matrix of semi-rigid pillars to form a skeleton interspersed throughout the membrane, thereby providing structural support to the IEM. Skeletal support is not mutually exclusive from the heterogenous reinforced composite membrane, but can reduce the mole fraction of inert PTFE in the film improving IEM conductivity or eliminate it totally.

### IEM Structural Support.

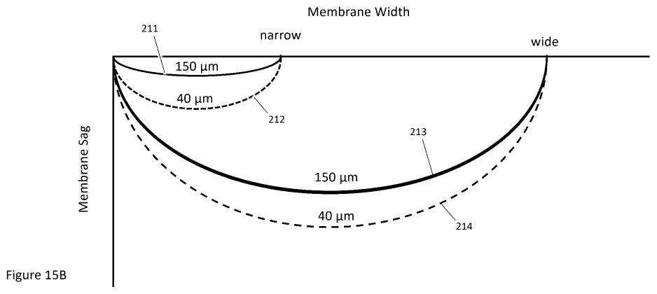

The biggest problem of a fuel cell is sagging and deformation of the active ionomeric film during manufacturing and in operation. This problem originates from the intrinsic relationship between the electrical conductivity and membrane thickness. As shown in FIG. 15A, the electrical resistivity 210 depends of the thickness of an ionomer—the thinner the film the better the conductance and the lower its electrical resistance.

Unfortunately, thinner films exhibit reduced mechanical strength and durability, causing them to sag and deform easily during handling and manufacturing. This increases the risk of damage during fabrication, manufacturing, and assembly of fuel cell or electrolysis modules. The term sag is defined as the deformation distance below the plane defined by the membrane's attachment points to its mechanical support. Ideally a membrane should be perfectly flat, coplanar with its edge support. Any deviation below the attachment plane is undesirable as it renders bonding between the gas diffusion layer and the membrane less uniform, potentially creating air gap pockets with no electrical contact, thereby increasing resistance.

The film sagging problem is further exacerbated in larger area membranes where mechanical edge support from the module assembly is farther removed from the center of the membrane and therefore less able to maintain film rigidity. As depicted in FIG. 15B cross sectionally representing the vertical displacement of a membrane, the center of a membrane sags below the horizontal plane of the membrane, with the greatest displacement in the center farther from any mechanical support.

For example, membrane 211 illustrates the characteristic sag of a narrow width 150-μm thick film. Despite reducing the membrane's mass, thinning membrane 212 to a 40-μm thickness decreases film rigidity thereby increasing the extent of the sag. Widening the distance across an IEM in order to achieve a larger area for greater current conduction further decreases mechanical support and further increases the magnitude of membrane sag as evidenced by 150-μm thick membrane 213 and even more so for 40-μm thick membrane 214. In other words every design and process change designed to enhance conductivity and reduce fuel cell resistance renders the ion exchange membrane less rigid and more subject to damage. The combined use of a thin large area membrane further exacerbates the film sagging problem, potentially rendering the membrane unmanufacturable.

Further complicating matters, most ionomeric membranes are made electrically active by conductive acid groups attached onto the main polymeric chain using an organic sidechain as an intermediary, i.e. as a pendant connecting the ionomer such as sulfonic acid to the backbone. While this approach provides additional control in trading off strength versus conductivity, it is inadequate to solve the mechanical rigidity issue during manufacturing.

Even worse, ion exchange membranes assembled into fuel cells can swell with water absorption during operation. The swelling occurs both laterally along the plane of the membrane and orthogonally to the membrane's surface impeding current and adversely affecting electrical conductivity. Swelling is a function of current, relative humidity, and temperature. Repeated cycles of swelling, e.g. from humidity cycling, also invokes various wear-out mechanisms shortening film integrity, reliability, and the use life of the membrane.

To resolve this problematic tradeoff between membrane conductivity and mechanical film strength, a new ion exchange membrane support structure is disclosed herein as an inventive embodiment comprising a skeletal support structure of electrically inactive pillars such as PTFE interspersed throughout the film at regular periodic intervals. When arranged in a waffle-like pattern, the skeleton is able to support thin membranes of arbitrary thickness unrelated to mechanical rigidity within the membrane's active polymer matrix. In one embodiment, this mechanical support or “endoskeleton” comprises semi-rigid pillars to which thin or fragile membrane can adhere. These pillars provide mechanical support to prevent film sag by holding the membranes tight, and in so doing reduce the range of atomic displacement with hydration.

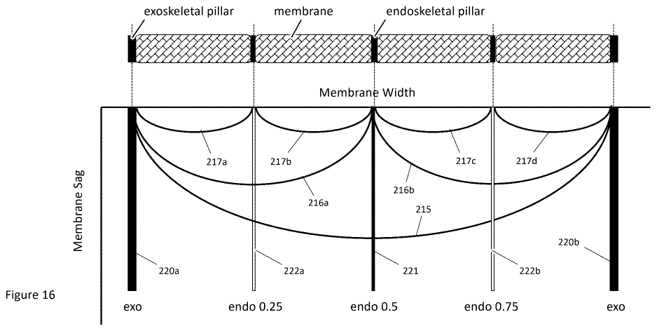

This principle for mechanical support is illustrated in FIG. 16 where the skeletal pillars of a single IEM are shown graphically in cross section. As depicted, these inert pillars surround the membrane's periphery and transection the film at regular intervals, generally evenly spaced. The pillars on the periphery 220a and 220b referred to as the membrane's exoskeleton are wider as the they are designed to be sufficiently wide to separate, i.e. singulate, each individual membrane from other IEMs fabricated in the same membrane-frame using a cutting mechanical or optical technique. The other pillars, referred to as an endoskeleton, may be constructed more narrow than the exoskeletal pillars as they are not intended to be cut. The exoskeletal and endoskeletal pillars are connected together to form a three-dimensional grid-like structure not visible in this two dimensional cross section.

Singulation may be performed by cutting the exoskeleton down its middle perpendicular to the film's surface using a laser, saw blade, or less ideally using a sharp edged mechanical punch. Laser singulation is preferred as it produces less mechanical stress on the film reducing the risk of tears, breaks, or damage to the membrane. The internal pillars 221, 222a, and 222b referred to herein as an endoskeleton, are as graphically represented narrower than that of the exoskeleton pillars 220a and 200b as they do not require cutting. After singulation, the endoskeletal grid remains a permanent artifact within the final IEM for use in a fuel cell, electrolysis unit, or filter application.

Referring to the graph curves 215, 216a, 216b, and 217a-217d illustrate the shape of the membrane for various support arrangements. Although the curves schematically represent in exaggerated form the shape of the membrane segments using various skeletal patterns, the abscissa of the graph also numerically represents vertical displacement or sag, with the peak displacement located laterally at the center between its two adjacent pillars. In membrane profile 215 exhibiting the greatest degree of sag, a membrane is supported only by exoskeletal pillars 220a and 200b. Adding a center endoskeletal pillar 221 bifurcates the film into two pieces 216a and 216b greatly reducing the sag. The benefit is made further evident by further subdividing the membrane into quartiles using endoskeletal pillars 222a, 221, and 222b positioned uniformly at 25%, 50% and 75% of the membranes width. The resulting reduction in film sag is represented by curves 217a, 217b, 217c, and 217d.

While the graph illustrates the addition of endoskeletal pillars in one dimension, the method can be applied in both axis, i.e. along the width and length of the membrane. Ideally, the spacing of the pillars long the x-axis and y-axis are substantially the same, forming a square frame to hold the active membrane. The square grid principle can be followed even when fabricating a rectangular shaped membrane simply by using integer number of squares to form the IEM. For example the width might comprise three endoskeletal pillars forming five segmented areas while lengthwise the distance may divided by 23 endoskeletal pillars forming 25 segments, five times the width. The net resulting shape is 5×25=125 squares with a net IEM aspect ratio of 5:1. Although the exoskeleton requires a minimal width to support singulation, there is no such restriction for the endoskeletal pillars which may be the same width as the exoskeleton or smaller, including the possibility of more than one endoskeletal width.

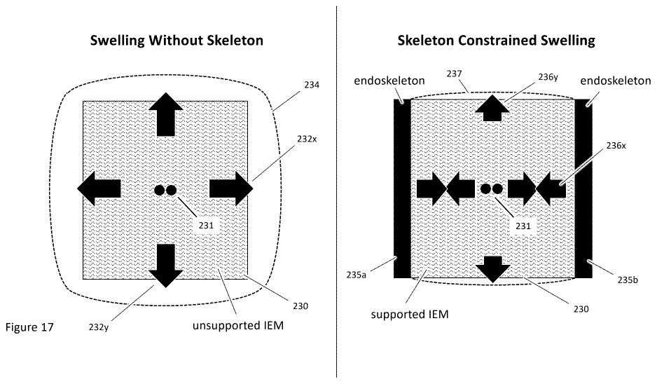

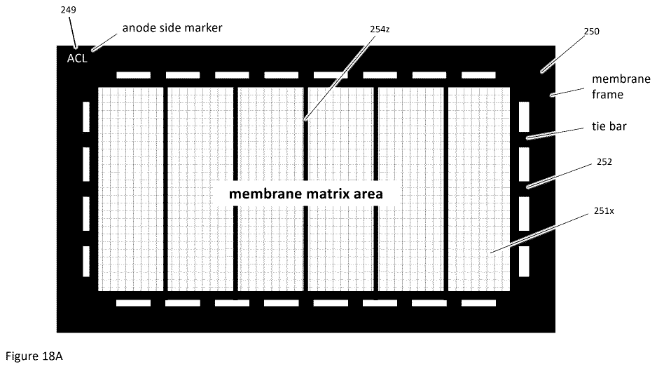

The benefit of the endoskeleton is not limited to manufacturing, it also aids in maintaining film integrity during operation. Specifically, ion exchange membranes physically deform during operation. The deformation can occur from local heating or retaining water, a mechanism referred to as membrane swelling. Humidity, temperature, and IEM current density all affect swelling. As depicted in FIG. 17, membrane swelling is greatly reduced by the use of an endoskeleton. Specially, in an unsupported membrane 230, the polymer molecules depicted as atoms 231 undergo expansive forces in all directions including in-plane forces 232x and force normal to the membrane surface 232y. Moreover these forces may not be uniform and local variations in temperature, humidity, current conduction, and film stoichiometry all affect expansive deformation. The result is an unpredictable change in volume 234. Deformation puts stress on the catalyst layer which can lead to cracking and permanent damage. Swelling can also reduce membrane conductivity further increasing heating. At a molecular level, repeated stretching comprising cycles of expansion and contraction can damage the membrane itself causing tears, gas leakage, and electrical shorts shunting electrical generation altogether. Other electrical mechanisms such piezoelectric effects can also impact the cell's electrostatic potential lowering the net voltage of the fuel cell stack.

By adding endoskeletal pillars 235a and 235b to IEM membrane 230 as support, in-plane forces causing expansion are countered in kind by opposing forces 236x exerted from the skeletal pillars thereby preventing displacement. Although the fuel cell polymeric matrix may be under pressure, essentially there is no where for the atoms in the polymer to move to except orthogonally in response to force 236y. Even so because of the molecular bonds between the polymeric IEM 230 and the endoskeletal pillars 235a and 235b, there is limited opportunity for displacement because the film surface is tethered on both ends. The resulting magnitude in displacement in the y-direction 237 is very limited even though there is no direct opposing force in perpendicular axis.

Formation of the exoskeleton and endoskeleton and design considerations for fuel cell applications are further elaborated in a related application “Advanced Fuel Cell—Design, Apparatus, & Fabrication,” referenced herein. In general the pillars of the membrane skeletal are formed by a polymeric compound such as a plastic such as a thermoplastic or polyolefin, PTFE, or glassy matrices reinforced by a filler such as carbon fibers, graphite, graphene, carbon nanotubes, and other mechanically strong insulating materials. In one implementation used to form the support pillars, finely powdered PTFE grains along with strengtheners are loaded into the mold and compressed to a high pressure between 10-to-100 MPa then heated to 360° C. to 380° C. to sinter the powder into a single polymerized mass. The addition of carbon fiber, graphene, carbon nanotubes, or polymeric shards provides added mechanical strength and support. In another embodiment the filler may include nanospun fibers of plastics or PTFE.

As described, the pillars are quasi-rigid, nonporous to gasses, not electrically conductive, and relatively inert chemically. One key design consideration is the active ionomer film filling the spaces between the pillars must adhere to the skeleton. The simplest way to ensure good attachment is to employ, at least in part, the same material in the pillars as those comprising the membrane. For example, forming the endoskeleton from PTFE with carbon filler and forming the membrane from PFSA coated PTFE means the membrane and the pillar are guaranteed to remain compatible because they both contain PTFE. Using a pure PFSA polymer as the membrane is more complex as the hydrophilic membrane must grafted onto hydrophobic PTFE skeleton using chemical reagents referred to herein as a ‘pillar link’ to bridge the two. Another option is to use a low mole fraction of PTFE mixed with PFSA as a powder of nanospheres in the membrane starting materials for dispersion casting. Other options include choosing a polymer with a more reactive surface to facilitate enhanced bonding.

### Membrane Matrix Frame.

Although the disclosed skeletal support structure strengthens the IEM membrane for operation and prevents mechanical damage to the film, by itself the endoskeleton and even the exoskeletal pillars do not facilitate convenient handling of the IEM during molding, post mold chemical treatments, catalyst formation, and attachment to the GDLs. In the referenced patent, one method to handle the thin film is to use temporary handles. A handle is a rigid block of material attached to one side of the membrane to facilitate handling needed to move the film from one processing step to the next without actually gripping the membrane. Although the use of handles including plastics, silicon wafers, metal, or polymers cand be used to transport the membrane among its processing steps, a handle suffers several limitations.

First the process of attaching a handle and then later detaching involves extra processing steps. Secondly, during chemical treatments portions of membrane attached to the handle are not exposed to the chemical reagents. This issue requires the assembly to be flipped over to treat both sides. Lastly, the attachment between the handle and the membrane can leave contaminant on the membranes surface. As such, it is better to coat both sides of the membrane with the catalyst layer before attaching any handle. But this requirement is paradoxical as there is no means to transport and coat the membrane without first attaching a handle.

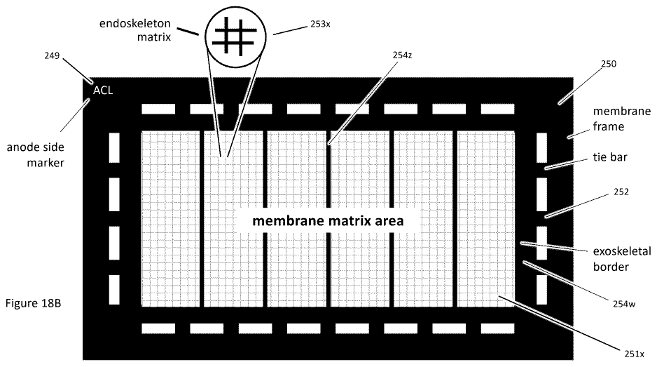

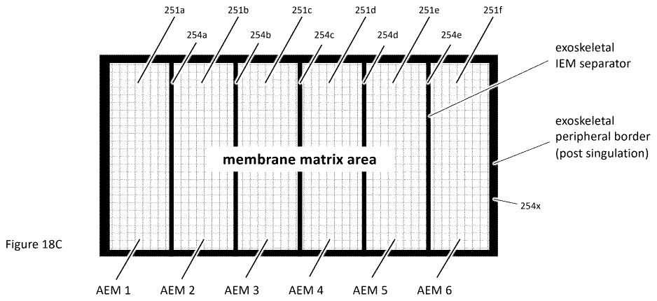

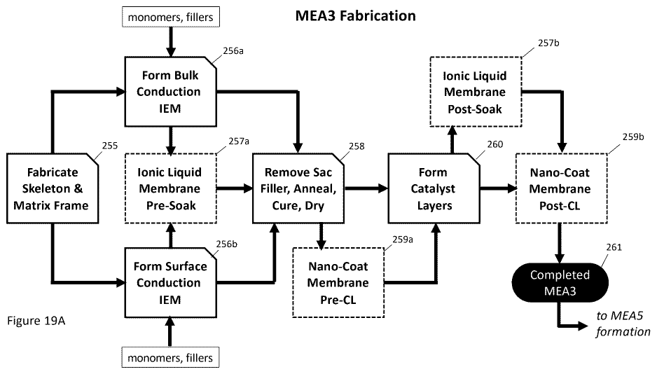

To resolve this persistent and extremely problematic handling issue in IEM fabrication, one embodiment of this invention is a “membrane matrix.” The membrane matrix comprises multiple ion exchange membranes fabricated concurrently, together circumscribed by a “membrane matrix frame”. The membrane matrix frame provides mechanical support for the array of membranes during fabrication. As shown in FIG. 18A, membrane matrix frame 250 includes a mechanically rigid material such as a carbon reinforced polymer surrounding membrane matrix 251x, the details of which are not shown. Membrane matrix frame 250 is secured to the membrane matrix 251x through regularly positioned tie bars 252. The circumscribing matrix frame 250, which is significantly stronger than the membrane matrix 251x it holds, provides mechanical rigidity of sufficient strength for mechanical or robotic handlers to firmly grab ahold of the matrix without damaging or bending the array contained within. Membrane matrix 251x is subdivided by inter-matrix exoskeleton 254z enabling greater mechanical strength during manufacturing and providing a means to manufacture multiple membranes in a single polymer sheet and subdivide them later, a procedure referred to by the semiconductor industry as “batch processing”. Batch manufacturing reduces production costs, improves quality, and makes products more uniform and better matched.

In one embodiment of this invention a marker or identifier 249 is included on one side of the frame to distinguish anode from cathode. The identifying mark may comprise an ink, fluorescent ink, indentation, etched, or stamped region identifiable using visible light, infrared, UV, or X-ray inspection. The marker which should be visible through a catalyst layer (CL) need not be visible through an attached GDL, since the MEA5 assembly process sequence can identify the anode from cathode and for example attach the CDL first meaning the last GDL to be attached identifies the anode side. With X-ray inspection, the GDL will not interfere with the inspection process.

Depicted in FIG. 18B, tie bars 252 connect outer matrix frame 250 to a wider more rigid periphery of membrane matrix 251 comprising exoskeletal border 254w circumscribing the membrane matrix area 251x. Membrane matrix area 251x in turn includes an array of multiple IEMs parsed by the skeletal matrix exemplified by a sample portion of endoskeleton 253x. In addition to endoskeletal support, the membrane matrix area 251x may also include exoskeletons 254z allowing one polymer sheet to produce multiple well matched IEMs.

During singulation only a portion 254x of the width of original exoskeleton 254w border survives the fabrication sequence as shown in FIG. 18C. As shown, 254A exoskeletal pillars 254a through 254e subdivide membrane 251x into multiple IEMs comprising IEM-1 251a, IEM-2 251b, IEM-3 251c, IEM-4 251d, IEM-5 251ae, and IEM-6 251f. The final multi-IEM membrane maintains structural support from its internal skeletal components despite the fact that none of the features of tie bars 252 or membrane matrix frame 250 survive. Pragmatically the thickness of the membrane handle is thicker than the membrane, a minimum requirement needed for compatibility with mechanical and robotic handlers.

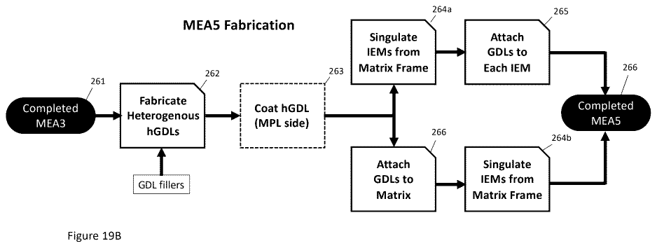

The overall process to form a MEA5 (i.e. CCM) with a matrix frame is depicted in the flow chart shown in FIG. 19A starting with step 255 “Fabricate Skeleton and Matrix Frame”. After that two choices exist for chemically forming the ionomer membrane. In step 256a “Form Bulk Conduction IEM” a semi-homogenous material is deposited, grown, or casted in the presence of the previously fabricated rigid skeleton and matrix frame. In the case of a PEM membrane, such a material may comprise a ionomeric polymer such as perfluorinated sulfonic acid, aka PFSA, formed as a semi-uniform film, or possibly intermixed with PTFE. Alternate membranes may comprise hydrocarbons functionalized by immobile acid groups such as sulfonic or phosphonic acids. Fillers may include both permanent fillers as well as a sacrificial filler. The material may be dispersion casted in a mold from powdered ionomer material or molded from a solution comprising a suspension of the ionomeric monomer in a solvent such as PFSA or hydrocarbon compounds.

Alternatively in step 256b “Form Surface Conduction IEM,” the fabrication may involve sequential steps of forming a non-electrically active polymeric backbone such as PFTE powder co-activated by grafting electrically active ionomer sidechains and pendants such as PFSA onto the mechanical support framework. The actual membrane chemistry and process steps thereof varies by material and by the conducting ionic species, e.g. protons H⁺ in a cation exchange membrane also referred to as a proton exchange membrane (PEM), or by anions such as —OH in an anion exchange membrane (AEM). More details of the membrane formation are discussed later in this application.

Subsequent to polymerization the process proceeds with the step “Remove Sac Filler, Anneal, Cure, Dry” 258 where the polymer is annealed, cured, and dried. In the event that the membrane includes a sacrificial filler, the filler is removed by a solvent prior to drying.

Alternatively, the membrane may be soaked in an ionic liquid in step 257a prior to curing. An ionic liquid comprises an organic salt that melts into a liquid state at room temperature releasing mobile cations and anions into a ionomeric polymer membrane. Because ionomeric membranes exhibit high specificity to only one polarity of ion transport, specifically hydrogen and hydronium cation transport in proton exchange membranes (PEM) or hydroxide anion transport in anion exchange membranes (AEMs), doping a IEM with an ionic liquid primarily enhances conduction in the dominant ionic species n the IEM. For example an IL introduced into phosphonic or sulphonic PEM membrane will enhance proton conductivity without increasing the number of ionized acid groups functioning as immobile anionic ionomers.

After polymer formation, membrane fabrication may proceed directly to catalyst layer formation shown by step 260. Alternatively in step 259a, the surface may be sprayed prior to CL formation with a nanocoating to enhance catalysis, reduce interfacial contact resistance, selectively suppress gas diffusion of fuels or toxins such as NO or H₂O₂, to suppress leakage of ionic liquids, or otherwise improve efficiency and/or enhance reliability. The coating may be sprayed subsequent to ionomer polymerization and prior to catalyst layer deposition, or subsequent to CL formation but prior to GDL attachments. The stochiometric contents of the nanocoating are discussed later in this application.

In step 260 “Form Catalyst Layers” the membrane is coated on both sides by a catalyst layer typically comprising carbon slurry mixed with a rare earth metal such as platinum (Pt), a metal oxide such as titanium dioxide (TiO₂), or a combination thereof. Other additives may include MOFs, POSS, or nanoparticles including functionalized nanotubes, graphene oxides, and nanoclusters. The specific catalysts used in the CL depend on the type of ion exchange membrane, either PEM or AEM, and may vary from the anode to cathode side of the CCM. The catalyst layer may be deposited using chemical vapor deposition, by printing, ultrasonic spray painting, or sputtering. Because the catalyst comprises a mix of various elements and compounds of varying liquid solubility and vapor pressure, CVD or printing methods are subject to variability in mass production.

In contrast, sputtering uses a non-thermal non-chemical process involving a mass transfer mechanism is better suited to deposit films of precise and identical stoichiometry to its source target. Sputtering is also capable of performing an in-situ pre-deposition sputter etch process to activate the membrane's surface ions, ameliorate unwanted surface states, and remove surface contaminants, thereby improving the electrochemical interaction between the catalyst and the IEM.

An alternative embodiment of catalyst layer formation adapted to this invention is to print or extrude a thin catalyst layer decal as a laminate to mechanically attach to each side of the membrane. Such laminate processes are subject to interfacial states, contaminant adhering to the IEM surface, and to air pockets, aka bubbles, unavoidably forming between the soft membrane and the CL decal during the lamination process. Special cleaning steps and squeegee steps such as Dr Blade processes are required as part of the lamination process sequence.

More details of the catalyst layer formation are subsequently discussed later in this application. Regardless of what method is used, however, the catalyst material must be applied to both opposing sides of the membrane, meaning the membrane must be turned over to expose the anode and cathode CL formation sequentially. After the catalyst layer is deposited the resulting sandwich is referred to as a MEA3 meaning a three layer membrane electrode assembly or ‘CCM’, an acronym meaning a cathode coated membrane.

Subsequent to catalyst layer formation, the membrane may be optionally soaked in an ionic liquid 257b, coated with a nanolayer 259b, or both. The resulting structure represents a completed three layer membrane electrode assembly MEA3 261 ready for attachment to gas diffusion layers. Although the described processes can be varied in alternate sequences, to protect the catalyst layer from ambient toxins the nanocoating process step 285b necessarily must follow CL formation 260. The same protection is not likely required on the anode side as the hydrogen source is generally ultrapure with no gaseous contaminants.

Alternatively, to enhance interfacial charge transport, the nanocoating formation 259a must precede CL formation step 260. Similarly ionic liquid s may be introduced into the membrane prior to CL formation in step 257a or thereafter in step 257b. Regardless of the sequence, one advantage of performing nanocoating process step 259b after ionic liquid doping is to seal the I_{L} within the membrane to prevent leakage. The unique process sequence made in accordance with this invention results in a completed MEA3 assembly 261.

As an embodiment of the membrane electrode assembly fabrication illustrated in FIG. 19B, two options exist to convert a MEA3 catalyst coated membrane into a into a MEA5 five-layer membrane electrode assembly. The steps involve first fabricating heterogenous gas diffusion layers (hGDLs) in step “Fabricate Heterogenous hGDL” 262 using printing or deposition of carbon fibers onto carbon fiber paper referred to as a microporous layer (MPL).

In an embodiment either the starting MPL or the carbon ink used to form the printed carbon layer may be embedded with GDL fillers. The GDL filler may comprise metallic or scavenger nanoparticles added principally to bond to, extract, and degrade nitric oxide (NO) and other airborne contaminants from being transported to the catalyst layer (CL) and thereby damaging or disabling the catalyst ions. In a hydrogen fuel cell the protective GDL filler nanoparticles are required primarily in the cathode GDL expose to air. In a direct methanol fuel cell however, contaminants may also be carried by an impure methanol source.

The lower case prefix ‘h’ is the acronym hGDL identifies the gas diffusion layer is heterogonous, not uniform in composition or atomic density where the deposited carbon layers may comprise stepped or graded coatings generally increasing in porosity monotonically. In one set of embodiments, the deposited layers included shorter higher density fibers adjacent to the MPL and more porous materials comprising longer carbon fibers subsequently deposited atop the higher density layers. In one embodiment, the gradations in carbon density vary in discrete steps while in other implementations the variations are more gradual.

Subsequent to the hGDL formation in the step entitled “Coat hGDL” 263, the MPL layer may be treated with a thin coating to improving mechanical attachment and electrical continuity between the MPL and the CCM's catalyst layers by reducing interfacial states, enhancing conductivity, and reducing interfacial stresses. MEA5 fabrication comprises two options, either to (i) attach the GDL gas diffusion layers to the MEA3 in step 266 then to singulate the IEM into separate pieces in step 284a, or (ii) to first separate the film into distinct components, i.e. to “Singulate IEMs from Matrix Frame” in step 264a then attach the GDL to each membrane piece individually in step 265.

Specifically in the sequence comprising step 264 “Singulate IEMs from Matrix Frame” 264a followed by step 265 “Attach GDL to Each IEM” the assembly method comprises separating the multi-IEM matrix into precut pieces before attaching similarly sized GDL layer. Such arduous assembly method involve more handling and therefore risk film damage. The alternate flow involving step 2666 “Attach GDLs to Matrix” followed by step 264b “Singulate IEMs from Matrix Frame” is a batch process postponing the singulation of the membranes into discrete IEMs to the last possible step. Regardless of the flow used, the final outcome is a discrete 5-layer membrane electrode assembly (MEA5) 266 ready for assembly into a module, either as fuel cell, an electrolysis unit, or as ion specific filter.

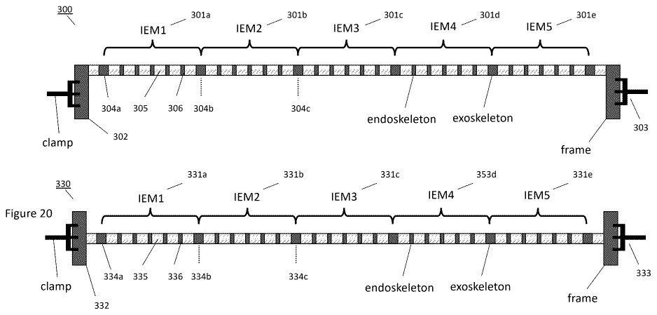

Using dispersion casting in a pressurized mold, ionomers can be formed into a matrix of thin ion exchange membranes and skeletons supported by a stiff thick matrix frame surrounding the array. In this manner, two different designs are possible as shown in FIG. 20—frame matrix 300 where the membrane 305 is offset vertically from the center of the frame 302, and frame matrix 330 where the membrane 335 is centered vertically at the center of the frame 332. As shown for matrix 300, the thin membrane 305 comprising five IEMs 301a-to-301e including exoskeletal pillars 304a, 304b, 304c is vertically offset from the center of the matrix frame 302 grasped by clamp 303. While simpler to fabricate than symmetric frame matrix 333, the asymmetric structure necessarily applies torque to membrane 305 from vertically offset clamps 303. In contrast, for matrix 330, the thin membrane 335 comprising five IEMs 331a-to-331e including exoskeletal pillars 334a, 334b, 334c, is vertically centered to matrix frame 332 grasped by clamp 333 and therefore does not experience torque or twisting forces.

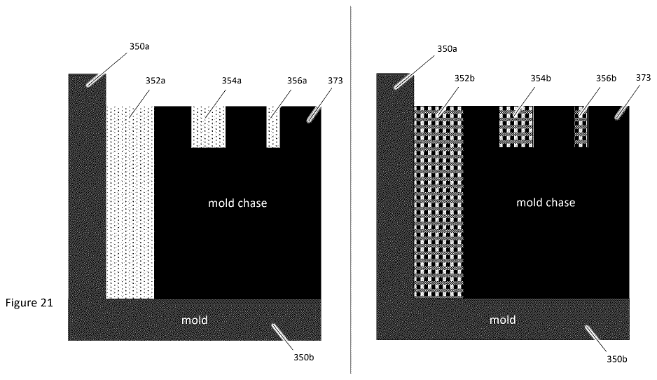

In one method the matrix frame, exoskeleton, and endoskeleton and concurrently molded using dispersion casting as shown FIG. 21 where a mold chamber comprising a sidewall 350a bottom portion 350b create a chamber which is reduced in volume by an insert referred to here as a mold chase 373 to produce several different open chambers of varying depth and width. In the example shown, the mold chase defines three different geometries of varying depth and width for loading monomer mold compounds into. Although the mold chase shown forms three different geometries having two different depths and three different widths, more regions of varying width and depth may also be employed. The mold chase 373, generally comprising stainless steel may be precision etched, cut, or milled to any dimensions. Mold costs depend on the mold and molding equipment—a larger mold chamber requires more steel and larger more expensive molding machines. Unlike injection molding, casting molds do not require the same precision tooling to prevent leakage.

In the example shown the mold defines at least one deep trench-like region 352a for the matrix frame, a second wider but shallower trench-like region 354a defining an exoskeleton and a third narrower shallow trench-like region 355a defining an endoskeleton. The various trenches are part of a three dimensional grid pattern that merge into another trench oriented perpendicular to the ones shown. The trenches are then filled to the top with a polymer mold compound such as a plastic or PTFE powder or a solution, then polymerized under heat and optionally light pressure, merging the monomers into a single piece of polymerized PTFE including regions 352b, 354b, and 356b which can be removed from the mold once it cools or partially cures.

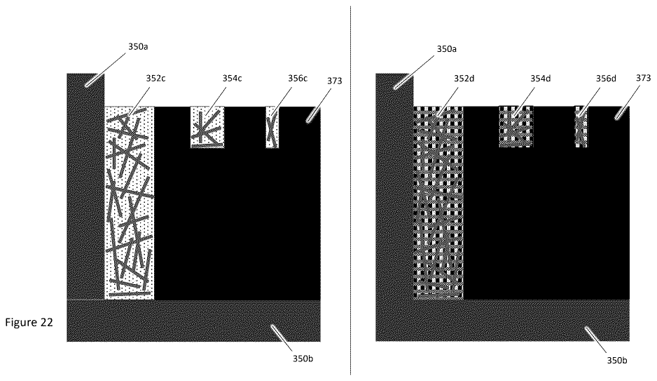

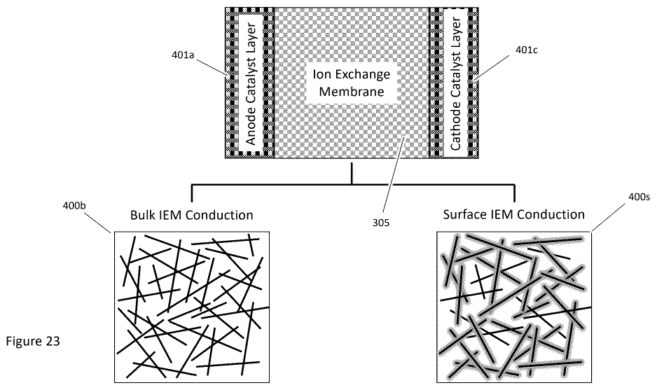

In another embodiment, shown in FIG. 22 the mold trenches 352c, 354c, and 356c are loaded with a heterogenous mix of a polymer such as PTFE and a some filler for increasing mechanical strength such carbon fiber, graphene, carbon nanotubes, plastic shards, or other materials. Heating under pressure causes the monomers in the dispersion or solution to polymerize with the fibrous filler, ultimately becoming permanently locked within the polymer's matrix as illustrated by matrix frame and skeletal features 352d, 354d, and 356d.

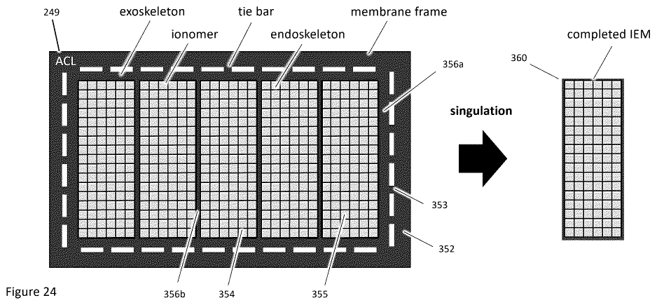

Subsequent processing of the skeleton fills in the intervening areas withing the skeletal grid with an ionomer or more accurately an ionomeric polymer. As shown in FIG. 23, the ionomer may comprise a bulk conducting IEM 400b such as polymerized PFSA, or a surface conducting IEM such as PFSA coated PTFE. The membrane matrix is then subsequently coated by anode catalyst layer (ACL) 401a and cathode catalyst layer (CCL) 401c to form the CCM sandwich as shown. The resulting membrane matrix shown in the exemplary top view of FIG. 24 includes a multiplicity of separate IEMs bounded by exoskeletons 356b and containing ionomer 355 and endoskeletal support 354.

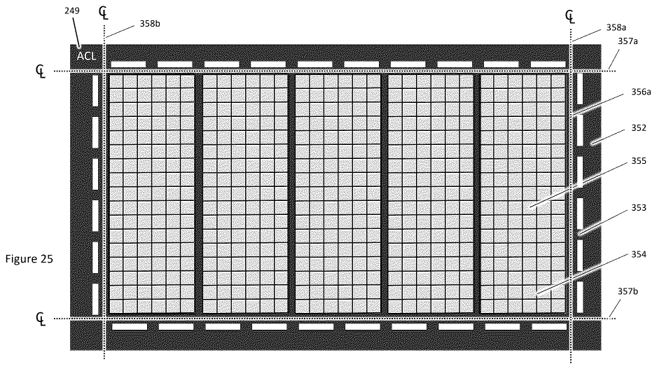

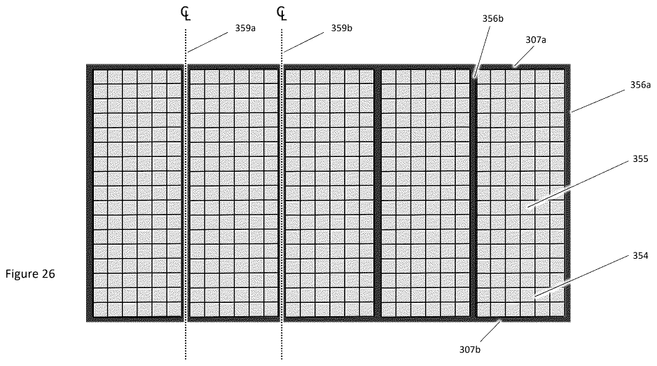

The entire structure is held together by a thicker wider supporting membrane matrix frame connected to the outer exoskeleton 356a by tie bars 353. After singulation where the membrane matrix frame is cut into pieces by laser, saw, or stamp, a completed IEM 360 a fraction of the size of the matrix results. FIG. 25 illustrates two horizontal cuts 357a and 358b and two vertical cuts 358a and 358b remove the completed matrices from the matrix frame while FIG. 26 illustrates cutting along the exoskeleton with exemplary cut lines 359a and 359b singulate the matrix into discrete IEMs.

Although the example shown illustrates a single 5×1 row of IEMs, the membrane matrix may include multiple rows such as a 5×2 grid by introducing additional horizontal exoskeletons similar to exoskeleton supports 307a and 307b into the patter. The shapes of the IEMs may be square or rectangular with aspect ratios typically of 5:1 or 7:1 and generally not exceeding 20:1. For example a 6×30 aspect ratio produces as active area of nearly 180 cm² neglecting are lost to the endoskeleton. At a current density of 200 mA/cm² this active area corresponds to a conduction current of 36 A and at of 500 mA/cm² results in a current of 90 A.

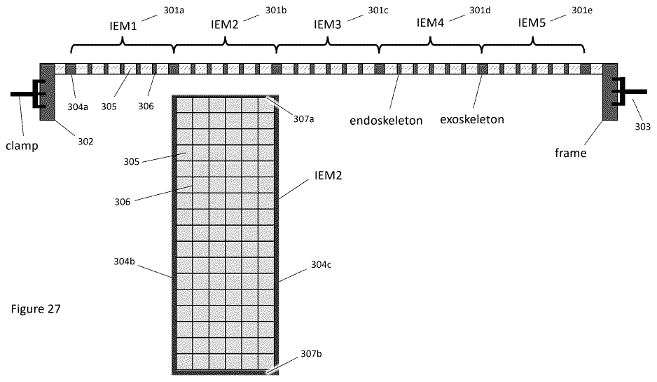

As described previously the relationship between the matrix frame and the membrane may be symmetric or asymmetric. The asymmetric design for concurrently fabricating IEM1 through IEM5 membranes 301a-to-301e shown in FIG. 27 include matrix frame 302 and clamp 303 not vertically centered on ionomer membrane 305. Although this cross section appears to lack structural rigidity along the width of the membrane from frame to frame, top view of IEM2 reveals exoskeletal support laterally via 307a and 307b not shown in the cross section. If added support is required to prevent sagging, additional exoskeletal rails can be added, rails that are not cut during singulation but remain in the final IEM.

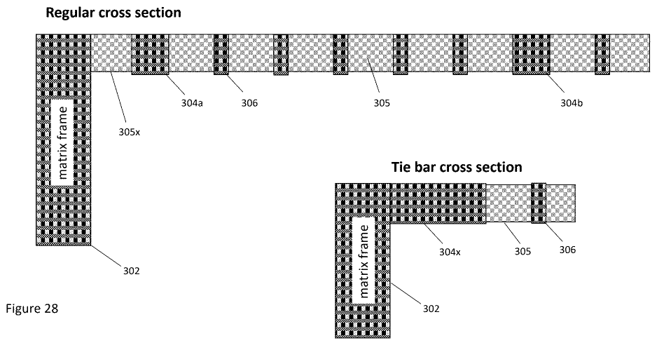

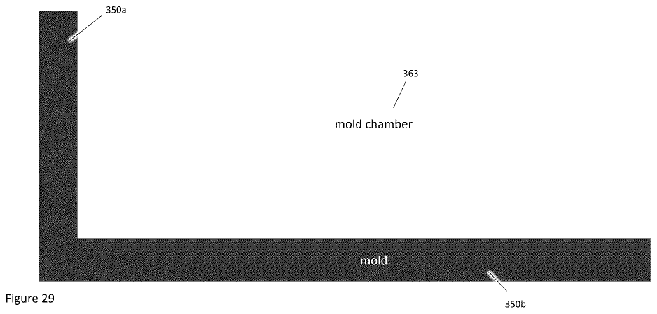

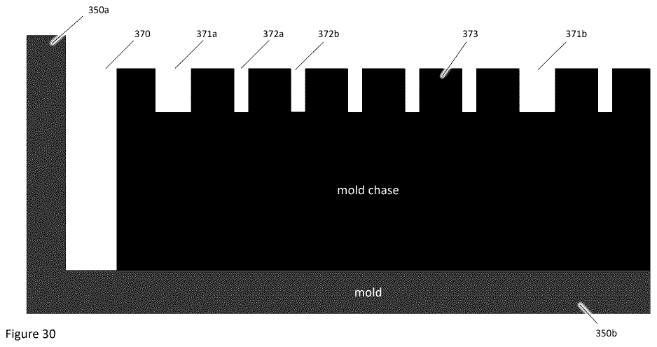

FIG. 28 illustrates a close up of IEM1, the membrane closest to the matric frame 302. Note that although the outer exoskeleton 304a could be merged into matrix frame 302 because they are different in thickness, it is advantageous to insert as space 305x shown in the regular cross section to in the provide some degree of flexing to prevent breakage. At regular intervals add support to the frame is provided by tie bars 304x merging exoskeleton 304a to matrix frame 302. One possible fabrication process to form an IEM with an asymmetric membrane frame is shown sequentially starting at FIG. 29 with mold chamber 363 having a bottom portion 350b and a side portion 350a.

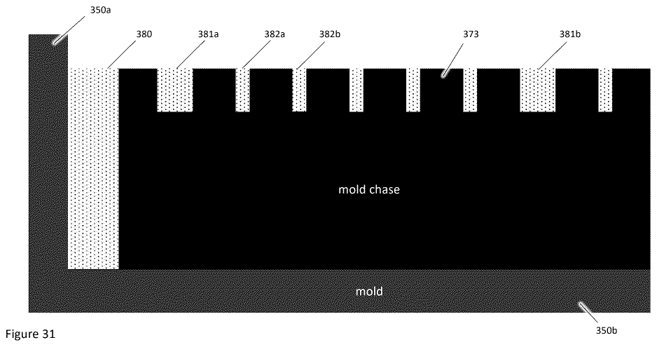

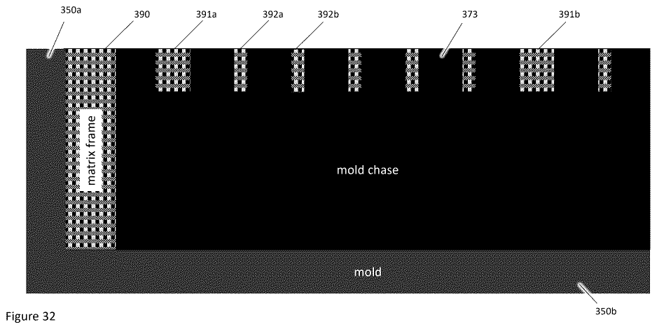

In FIG. 30 a mold chase 373 is inserted reducing the volume of chamber 363 to defined regions to insert polymer for the skeletal and frame support of the matrix. These trenches identified by the element they form include frame region 370, exoskeleton regions 371a and 371b, and endoskeleton regions 372a, 372b and other regions not labelled. In FIG. 31 mold chase 373 is loaded with the mold compound and any filler to frame region 380, exoskeleton regions 381a and 381b, and endoskeleton regions 382a, 382b and other regions not labelled. In FIG. 32, the compound is polymerized forming the membrane matrix including frame region 390, exoskeleton regions 391a and 391b, and endoskeleton regions 392a, 392b and other regions not labelled.

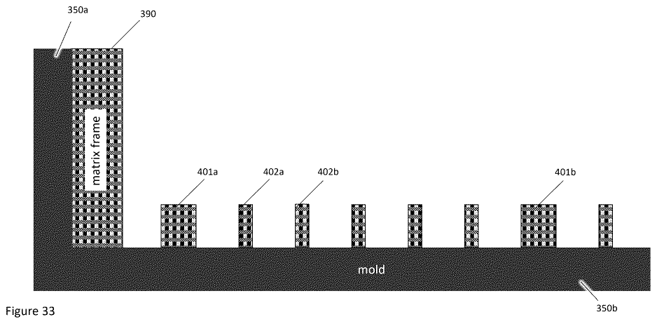

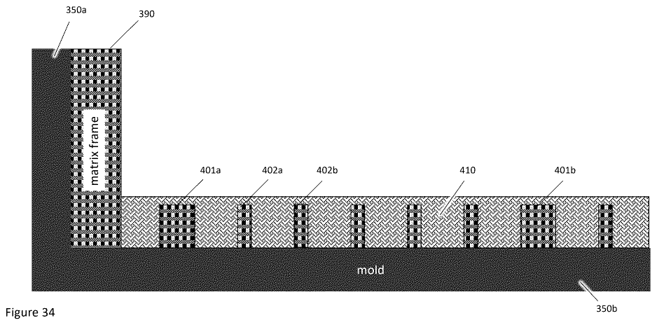

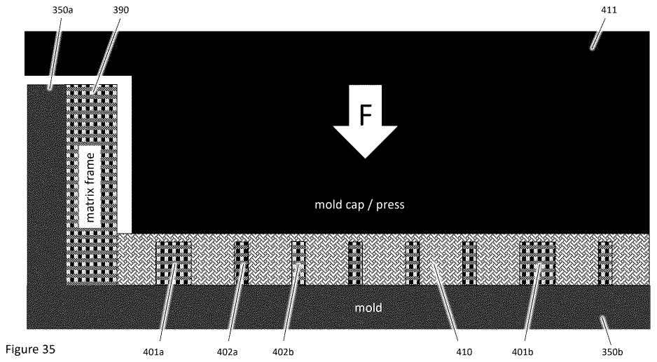

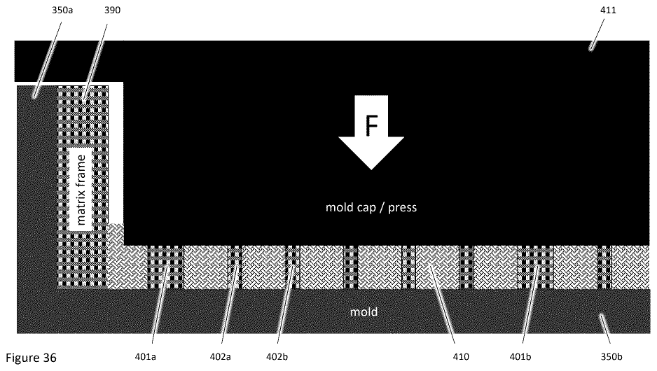

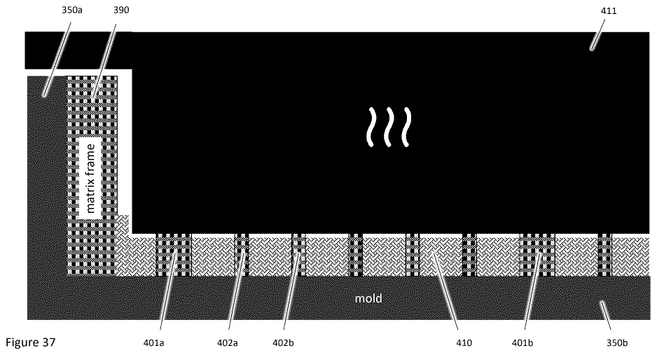

The polymerized matrix is then removed from the mold chase, the mold chase is removed from the mold chamber and the completed frame and skeleton is flipped over withing the chamber comprising frame feature 390, exoskeleton features 401a and 401b, and endoskeleton features 402a, 402b and other regions not labelled as shown in FIG. 33. The ionomeric compound 410 is then loaded into the mold as shown in FIG. 34, followed by lightly pressurized force with mold cap 411 in FIG. 35. The purpose of mold cap 411 is not to apply high pressure but to hold the mold compound, solvents, and cross linkers in place during polymerization. The monomeric contents are then cross linked into a polymer as shown in FIG. 36 including any heating treatment to accelerate cutting or drying.

During the polymerization process shown in FIG. 37 the ionomer volume may shrink slightly whereby the exoskeleton pillars 401a, 402a and endoskeleton pillars 402a and 402b may extend slightly above polymerized ionomer 410. The expansion or contraction of a polymer during polymerization depends on the specific chemistry of the polymer. The matrix frame is then removed from the mold and optionally treated using post molding chemical processes including additional curing, rinsing, drying, soaking, or coating. Subsequent to polymerization but before forming the catalyst layers, an ionomeric film made in accordance with this invention may be (i) soaked in ionic liquid to dope the membrane for higher conductivity; (ii) nanocoated to enhance interfacial properties; or (iii) both. In the third case, the nanocoating may also be utilized to prevent leakage of I_{L} from the membrane. In some instances nanocoating materials such as PTFE nanospheres or dopamine (DPA) may be integrated into the catalyst layer rather than being applied separately. It should be noted that while depositing a nanocoating prior to CL deposition, i.e. forming a nanocoated interfacial layer between the membrane and the catalyst layer can also intercept poisons such as H₂O₂ from diffusing into the membrane and damaging the ionomeric groups, it cannot protect the catalyst layer from environmental contaminants as it is located beneath the CL, not between the CL and GDL.

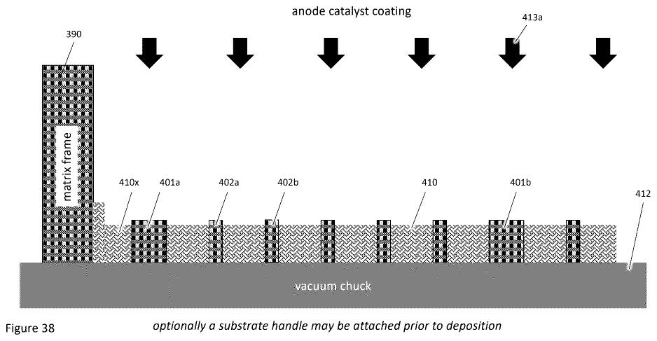

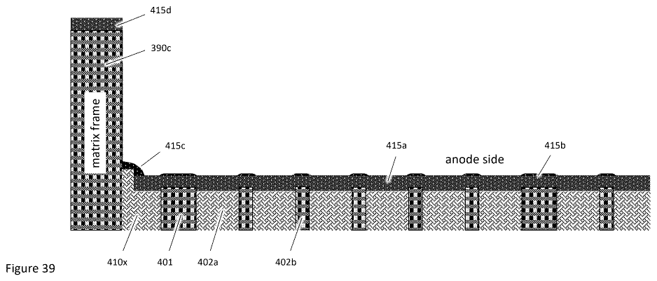

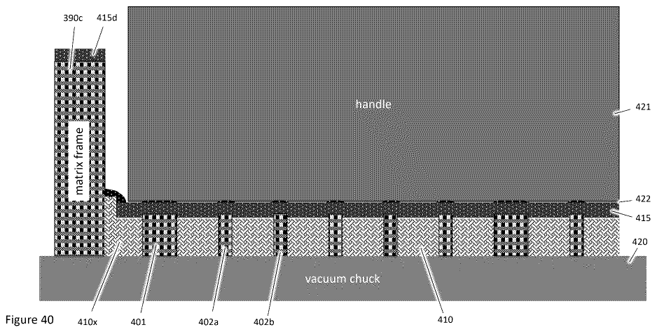

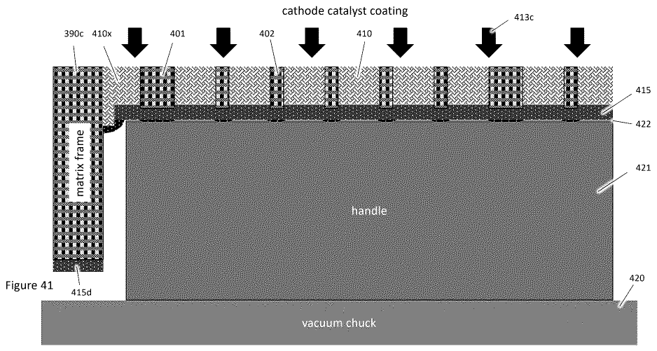

FIG. 38 illustrates the matrix frame is then placed flat side down onto vacuum chuck 412 for sputter deposition 413a of the catalyst layer, e.g. to form the IEM anode. The illustration shows no added support to the matrix, but optionally a handle or protective coating can be attached to the flat side prior to this step. After CL coating shown in FIG. 39 the catalyst is present in flat regions 415a, atop the skeletal pillars 415b, along the interior edge of the frame 415c, and atop the frame 415d. Only regions 415a atop the ionomer 402a are electrically active. For cathode CL coating the entire assembly must be flipped upside down. Because of the tall frame it cannot be placed directly on the sputtering chuck unless until handle support 421 is first attached as shown in FIG. 40.

The handle can be any thick protective coating, or comprise a metal, silicon, or polymer slug designed to match the size of the matrix frame. Because of the possible slight height difference between the pillars 401, 402a and 402b compared to ionomer 410, the handle 411 may not uniformly contact catalyst layer 415, but instead include a small gap 412. In actual use, assembly pressure within a fuel cell state eliminates the gap, but preferably membrane synthesis conditions can be optimized to minimize or eliminate the gap.

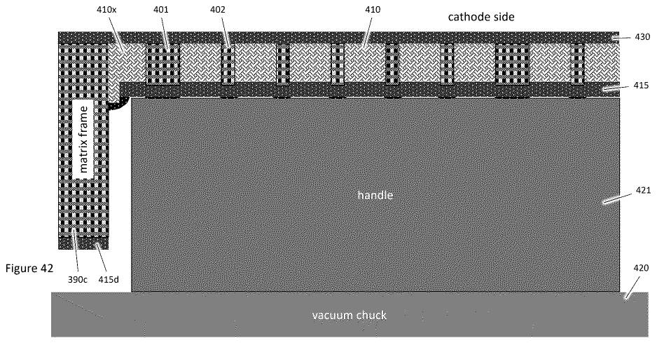

In FIG. 41 the entire assembly is flipped upside down so that catalyst 453c deposition can be performed. As described previously, a nanocoating formed subsequent to membrane polymerization and prior to GDL attachment may either immediately precede catalyst formation; may follow CL formation, or alternatively may be integrated into the catalyst layer during its formation.

Because handle 421 is thicker than matrix frame 390c, the frame will interfere with thermal conduction from heat chuck 420 into the deposition surface. The problem is remedied by inclusion of a thermally conductive handle 421 smaller the membrane matrix. Handle 421 may comprise metals such as copper or steel or may comprise silicon wafers. FIG. 42 shows the film immediately after the cathode catalyst layer 430 has been deposited while still attached to handle 421 and vacuum chuck 420.

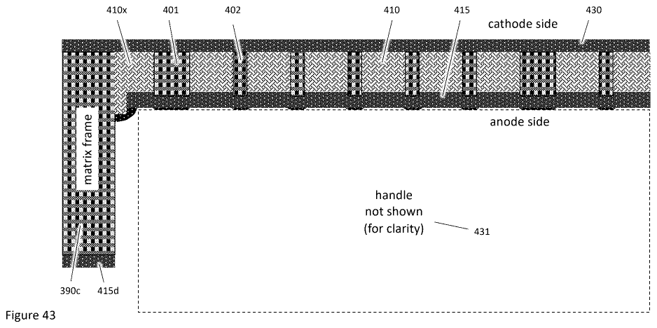

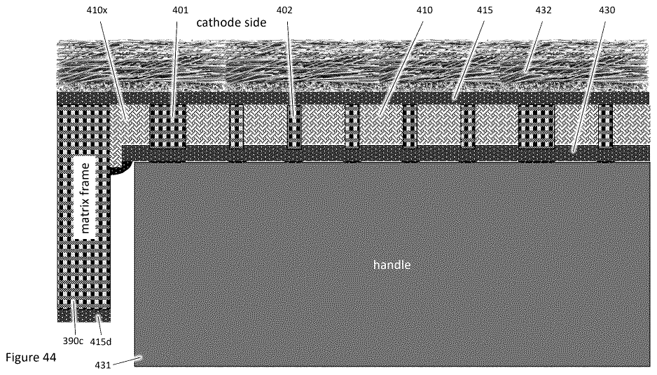

FIG. 43 illustrates the completed CCM still connected to the matrix frame. For the sake of clarity, the handle 421 has been removed from the illustration, identified as vacant region 431. Before attaching gas diffusion layers (GDLs) but subsequent to CL formation, an ionomeric film made in accordance with this invention may be soaked in ionic liquid (IL) to dope the membrane for higher conductivity. A nanocoating deposited atop the catalyst layer which may included carbon and other conductive components such as graphene, functionalized nanotubes, metal-organic-frameworks (MOFs), transition metal oxides, zirconium and tungsten compounds, and other permanent fillers discussed later in this application, may be included to reduce interfacial resistance between carbon in the GDL and the catalyst layer.

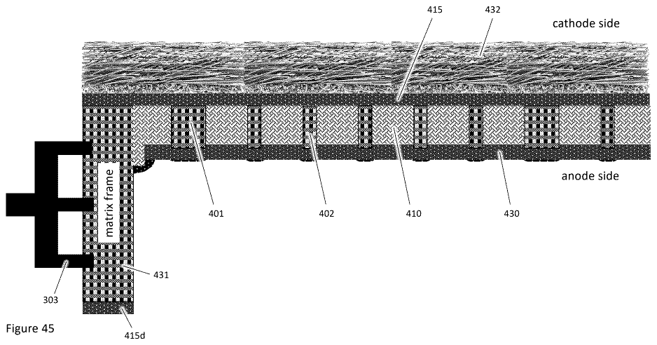

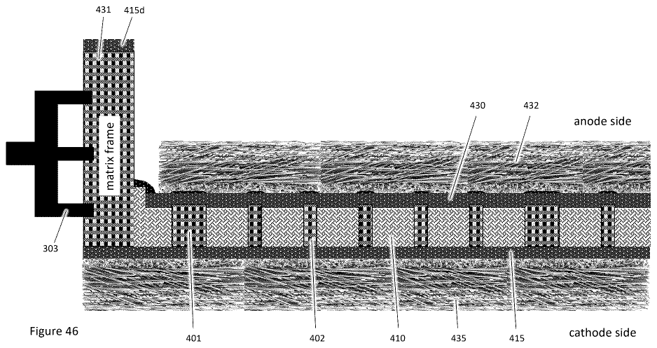

In FIG. 44, gas diffusion layer GDL 432 is attached to the cathode. During the cathode GDL attachment process as shown the GDL is attached to the entire membrane matrix area containing multiple IEMs contained with the same frame. Thereafter in FIG. 45 the handle is removed. In FIG. 46 the anode gas diffusion layer GDL 432 is then attached on the opposite face of the CCM.

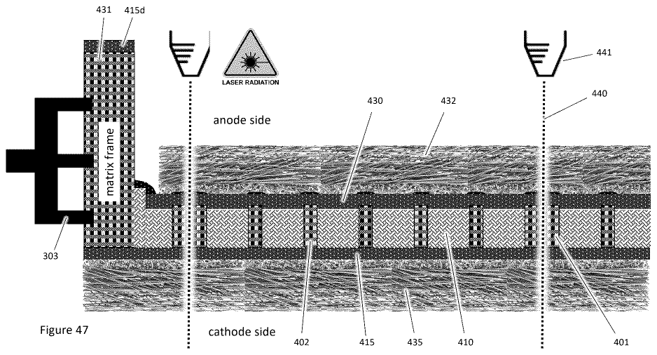

In the batch process as shown, multiple MEA5 assembly are made concurrently, followed by laser 441 singulation along defined cut line 440 shown in FIG. 47 to separate them into discrete components ready for assembly into a fuel cell array. Methods to assemble the fuel cell are further elaborated in the application “Advanced Fuel Cell: Design, Apparatus and Fabrication.” Because the GDL comprises a laterally-unform carbon sheet with no defining features, no alignment is necessary when attaching the two GDLs to the CCM. Instead the final shape of the IEM is defined by its laser singulation step cutting through the GDLs 432 and 435 and through the wider exoskeletal pillars 401 surrounding individual IEMs.

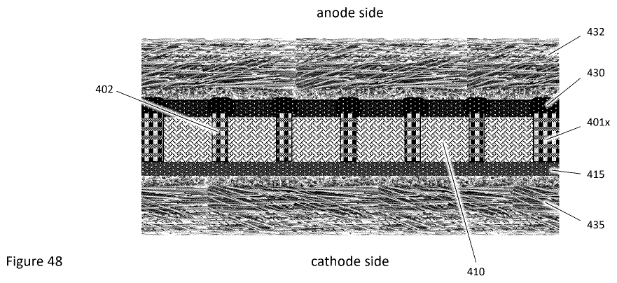

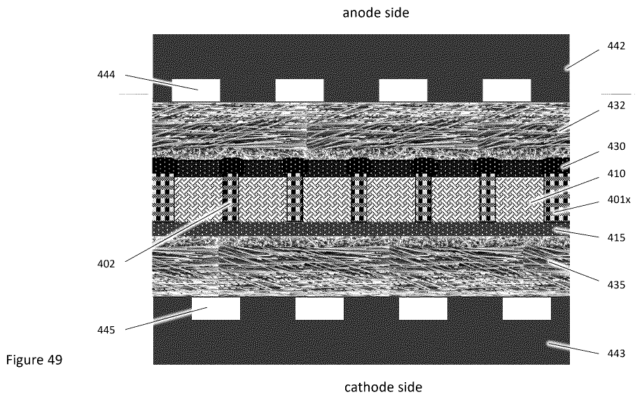

The completed five-layer MEA5 following singulation is shown in FIG. 48. Features from top to bottom include gas diffusion layer GDL 432, catalyst layer 430, ion exchange membrane 410, endoskeleton 402 and surviving portion of the exoskeleton 401x, catalyst layer 415, and gas diffusion layer GDL 435. FIG. 49 illustrates the IEM as a seven-layer MEA7 after addition of bipolar plate 442 contacting GDL 432 and bipolar plate 443 contacting GDL 435. The juxtaposition of bipolar plate 442 and GDL 432 form gas channel 444. Similarly on the other side of the IEM bipolar plate 443 and GDL 435 form gas channel 445. Depending on the type of fuel cell the specific gases carried in gas channels 444 and 445 differ for the anode and cathode side of the MEA7.

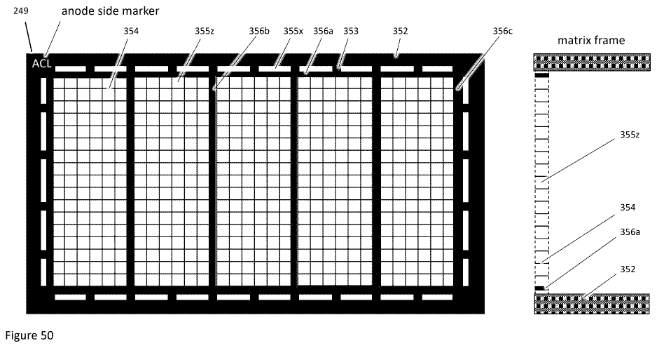

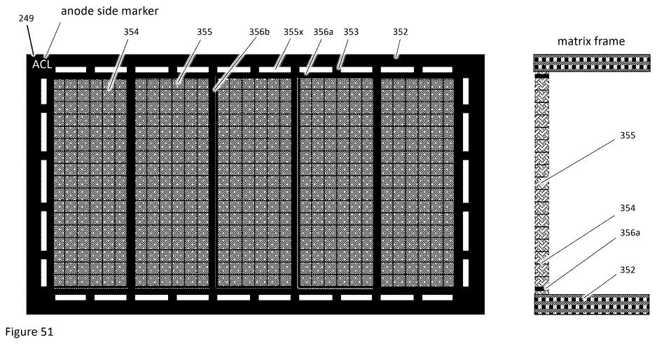

To further elucidate the structure of the membrane matrix during fabrication, a concurrent depiction of the top view of the matrix frame and a side view of the skeleton/membrane/frame can be illustrated at various steps in the process. FIG. 50 illustrates the top and side views of matrix frame 352 after frame and skeletal molding. Located laterally within the outer frame 352 is a matrix of multiple IEM defined by exoskeletal grid including peripheral lateral and vertical components 356a and 356c connected to the outer matrix frame on the periphery by tie bars 353. At this step in fabrication, the openings in membrane frame 355x and 355y located between the inner edge of frame 352, the outer edge of peripheral exoskeleton 356a and 356c, and betwixt tie bars 353 is unfilled but will later be filled with the same ionomer as formed within the IEM membrane.

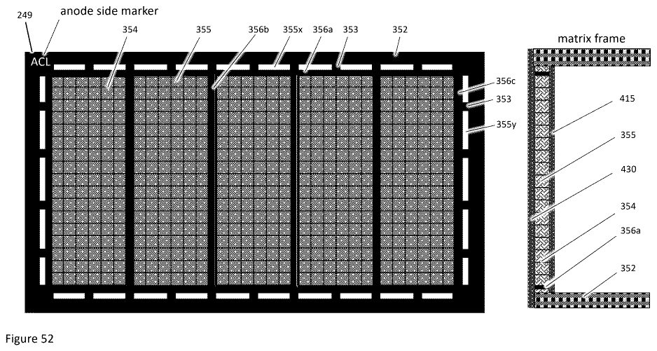

Other exoskeletal pillars 356b transecting the matrix array separate it into individual IEMs, in this example comprising vertically oriented pillars. Depending on the design and number of peripheral exoskeleton pillars 356a and 356c, and transecting exoskeletons 356b and more, together, collectively as exoskeleton 356, may form a membrane matrix having multiple rows and/or columns of IEMs. Contained within each exoskeleton-bound IEM is a grid of endoskeletons 354 defining square or rectangular areas 355z where the ionomer membrane is to be subsequently formed. FIG. 51 illustrates the membrane matrix frame after forming polymeric ionomer 355 in previously unfilled openings 355z. The polymer must laterally adhere and bond to the endoskeleton 354 to form a stable film. In FIG. 52 catalyst layers 415 and 430 are formed onto the membrane and skeleton 354.

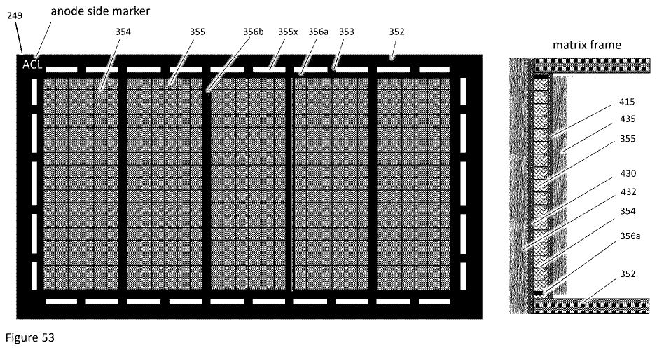

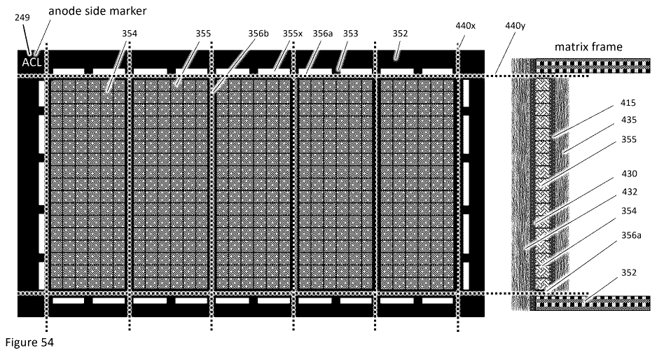

In FIG. 53, the gas diffusion layers are attached to form a MEA5. Specifically GDL 432 is attached to catalyst layer 430 of the CCM while GDL 435 is attached to catalyst layer 415 of the CCM. The height of GDL 435 is constrained vertically by the matrix frame. The outer GDL 432 located on the flat side of the asymmetric matrix frame may be the same dimension as the inner GDL 435 or may be larger.

FIG. 54 illustrates the cut lines through the exoskeletal grid of the membrane matrix and frame including vertical cut lines 440y and horizontal cut lines 440x. Cuts performed between any two adjacent IEMs separate the IEMs from one another while cuts between the edges of IEMs abutting the frame separate the IEMs from matrix frame 352.

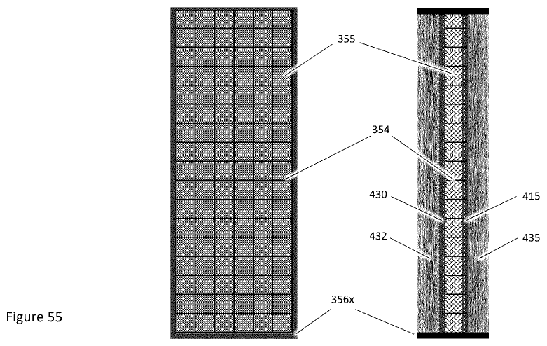

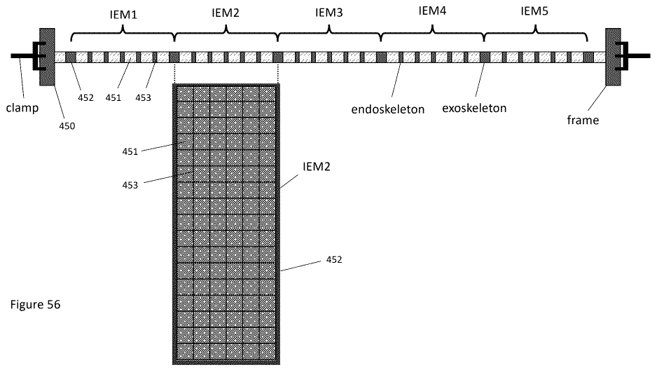

FIG. 55 illustrates the top view and cross section of the resulting discrete IEM comprising the remaining width of the exoskeleton after cutting 356x, the endoskeletal grid 354, the thin ionomer 355. The CCM three-layer MEA3 including catalyst layers 430 and 425 is bounded by GDLs 432 and 435. During cutting the 432 GDL side of the membrane assembly may be attached to sticky tape, often referred to as blue tape, to hold the IEMs in place during cutting.

Once singulated, the individual IEMs can be removed from the sticky tape and assembled into the fuel cell assembly. In one embodiment, the singulated MEA5 are removed from the sticky tape using a pick and place machine and loaded into the fuel cell μstack or stack with no human handling. In this case, the elimination of handling by factory automation reduces the risk of damage to the membrane and improves manufacturing yield and quality.

In contrast to the foregoing asymmetric frame method, a symmetric membrane matrix frame concurrently fabricating IEM1 through IEM5 membranes 301a-to-301e is shown in FIG. 56 including matrix frame 451 and clamp 450 vertically centered around ionomer membrane 451 and associated exoskeleton 452 and endoskeleton 453. Top view of IEM2 reveals exoskeletal support and endoskeletal pillars 453 form a waffle like grid to support ionomer film 451.

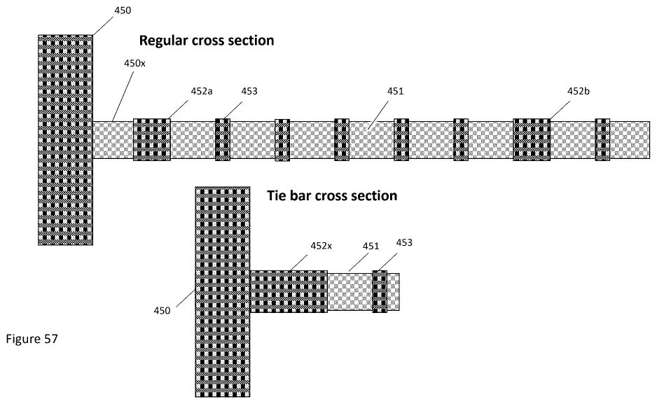

FIG. 57 illustrates a close up of IEM1, the membrane closest to the matric frame 450. Note that although the outer exoskeleton 452a could be merged into matrix frame 450, because they are different in thickness, it is advantageous to insert as space 450x shown in the regular cross section to in the provide some degree of flexing to prevent breakage. At regular intervals add support to the frame is provided by tie bars 352x merging exoskeleton 452a to matrix frame 450.

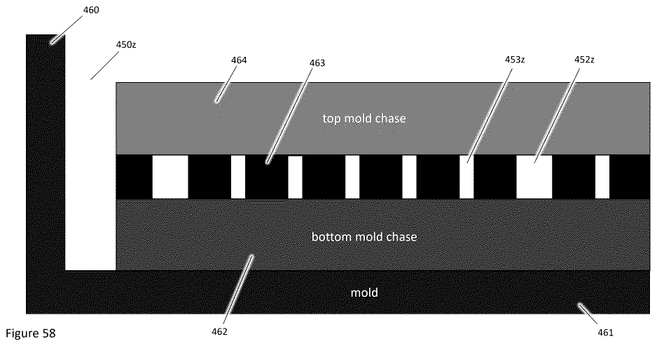

To form a symmetric frame vertically disposed around a matrix of IEM membranes, the molding process is more complex than in a symmetric design. As shown in FIG. 58, a mold chamber comprising base 451 and sidewalls 460 is filled with a tri-layer mold chase, the mold chase being a precision milled steel insert than limits the dimensions of the mold during dispersion casting, injection molding, or transfer molding.

The bottom and top mold chases 462 and 464 respectively are solid and of the same dimension. The inner or intermediate mold chase 463 also has the same exterior dimensions but includes openings 452z and 453z of varying widths which later will correspond to exoskeleton 452 and endoskeleton 453. The stack of aligned mold chases includes a lateral gap 450z separating it from the sidewall of the mold chamber 460. This dimension of gap 450z is controlled by spacers or registration keys not shown inn the figure cross section.

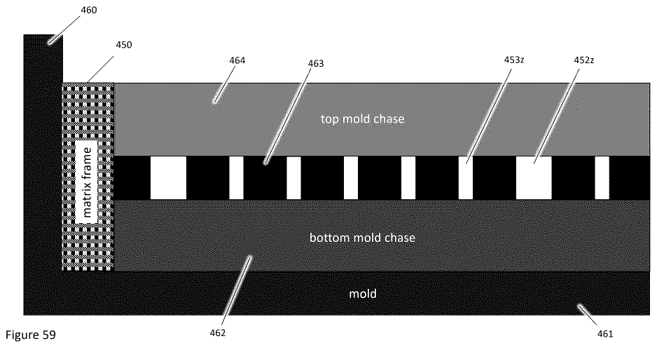

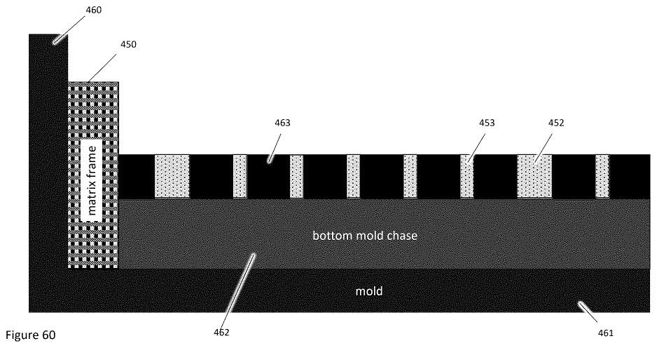

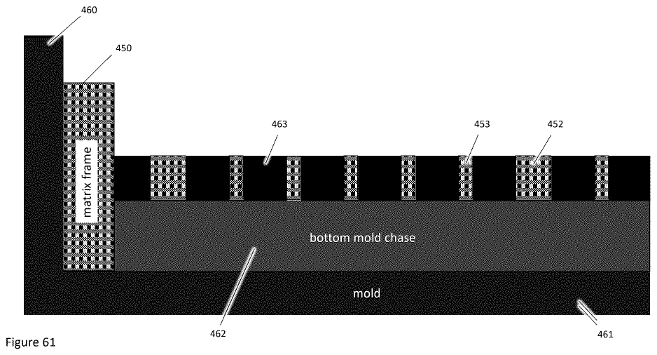

In FIG. 59, gap 450z is filled by a polymer dispersion such as PTFE or a hydrocarbon polymer and optionally with strengthening fillers such as carbon fibers, graphene, plastic shards, electrospun fibers, or carbon nanotubes and polymerized to form matrix frame 450. In FIG. 60, top mold chase is removed and openings 452z and 453z are filled with a polymer dispersion such as PTFE and optionally with strengthening fillers such as carbon fibers, graphene, or carbon nanotubes to form pillars 452 and 453 coplanar with the top of inner mold chase 463. If the ionomer slightly overflows slightly onto the top of intermediate mold chase 463 it has no substantive impact on the thickness of the film or its electrical properties. FIG. 61 illustrates the skeletal fabrication step after polymerization.

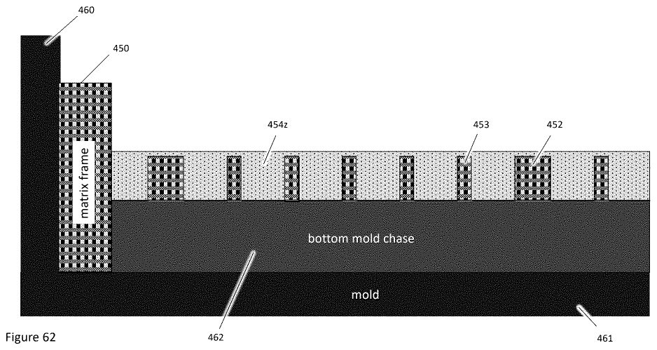

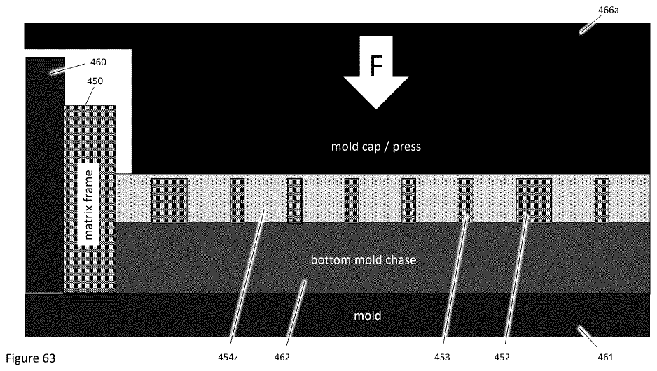

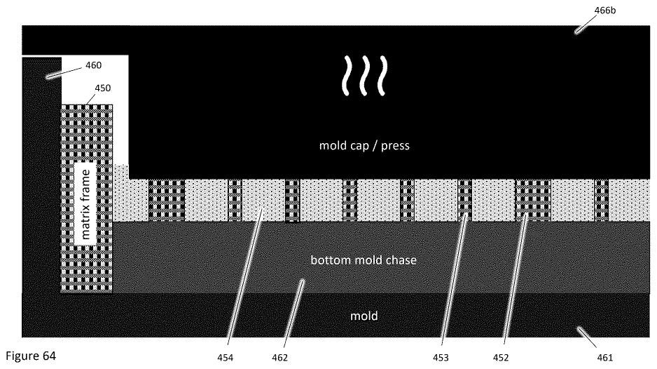

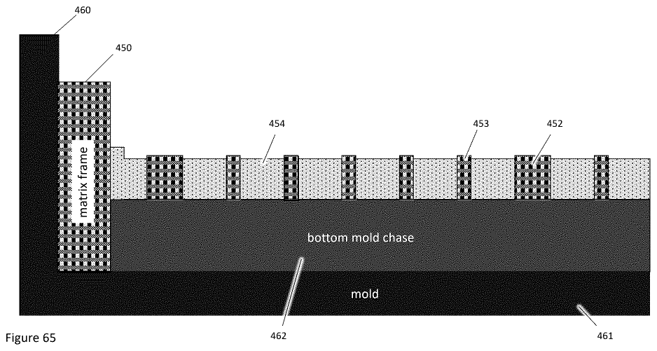

In FIG. 62, the intermediate mold chase 463 is removed leaving the frame 450 and fabricated skeletal pillars 452 and 453 intact. The chamber is then filled with a prescribed quantity of mold compound 454z, pressured by mold cap/press 466a in FIG. 63 then heated by mold cap/press 466a in FIG. 64 to form polymerized ionomer 454 shown in FIG. 65. Depending on the polymer's formulation, during the polymerizing process the height of ionomer 454 may shrink slightly below that of pillars 452 and 453.

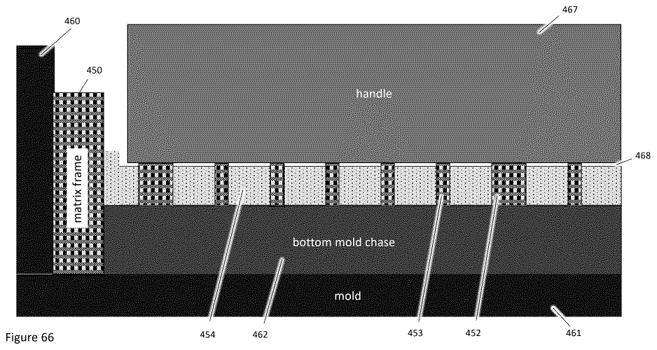

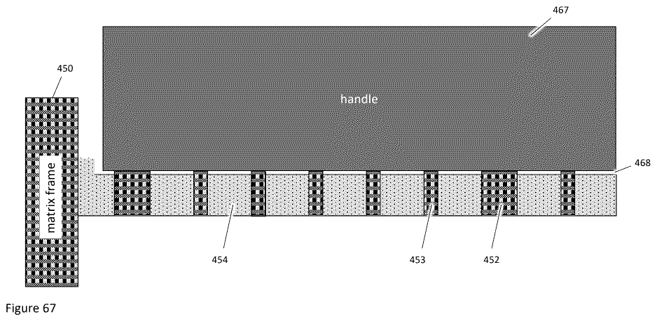

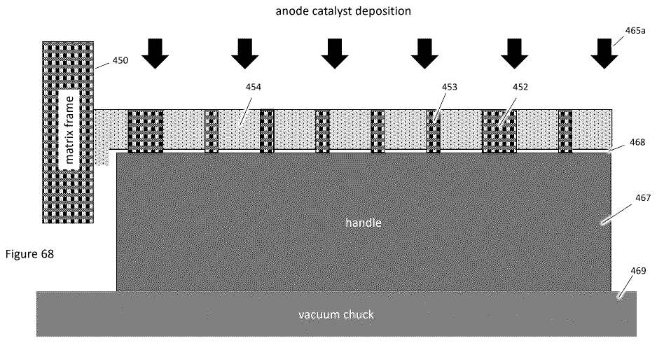

In the step illustrated by FIG. 66, handle 467 is attached to the matrix comprising ionomeric membrane 454 and pillars 452 and 453. If the pillars are taller than ionomeric membrane 454, a small gap 468 mat result whereby handle 467 attaches to only pillars 452 and 453. The lateral extent of the handle must be at a dimension smaller than the interior edge of matrix frame 450. Removing the matrix from the mold with handle 467 still attached is shown in FIG. 67.

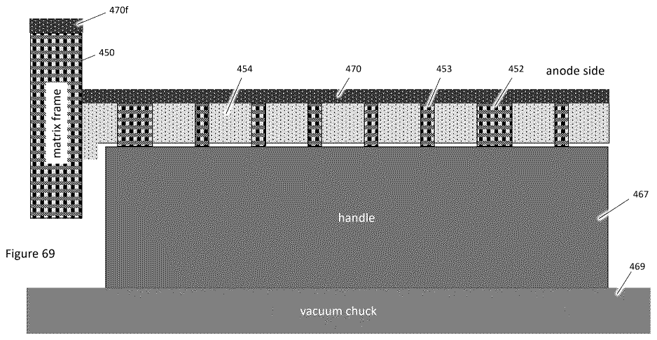

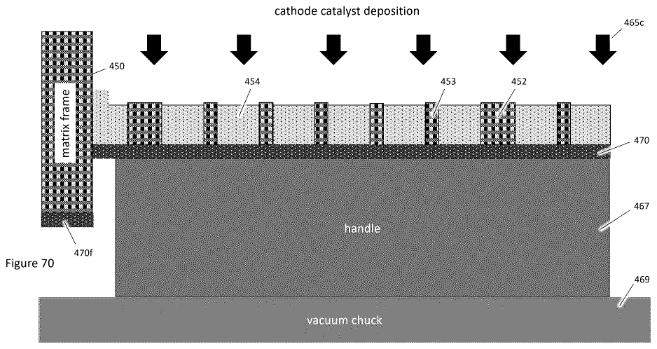

Flipping the assembly over for anode catalyst deposition 465a is shown in FIG. 68 where mechanical support and heating during deposition is provided by handle 467 sitting atop heated vacuum chuck 469. As described previously a nanocoating may be formed between the membrane polymer and the catalyst layer, as nanospheres or permanent fillers within the catalyst layer, or between the catalyst layer and the GDL. After anode catalyst deposition, catalyst layer 470 is formed atop membrane 454 and peripherally deposited as unfunctional layer 470f atop frame 450 as depicted in FIG. 69. Because the thickness of handle 467 is thicker than the height of frame 450 the frame does not effect attachment of membrane matrix and handle 467 to vacuum chuck 469.

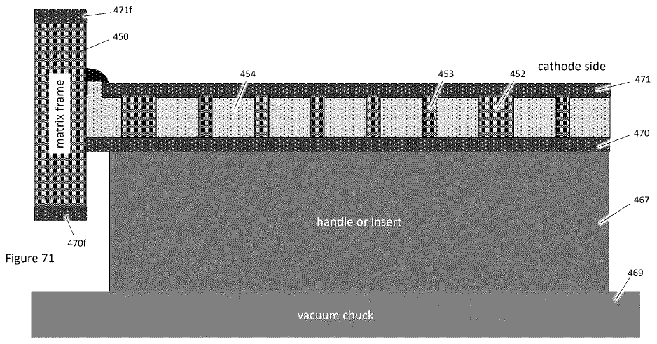

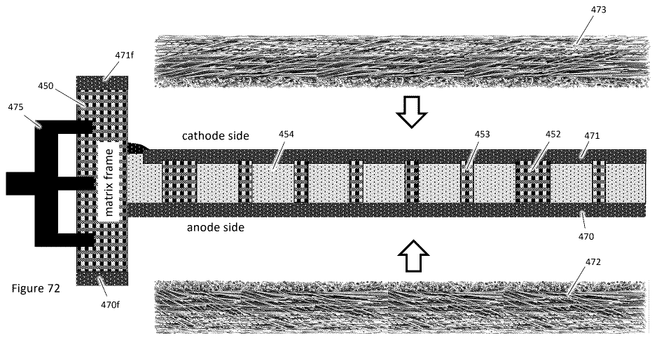

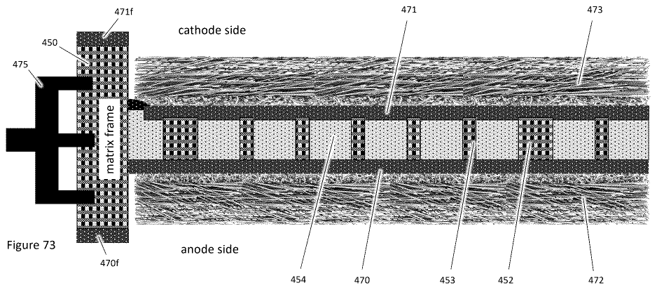

The handle is then removed from the cathode and reattached to the anode side of the film. As shown in FIG. 70 and FIG. 71, the cathode catalyst layer is then deposited 465c onto the cathode side of the membrane while heat is supplied from vacuum chuck 469 via handle 467. As described previously, a nanocoating may be formed between the membrane polymer and the catalyst layer, as nanospheres or permanent fillers within the catalyst layer, or between the catalyst layer and the GDL. The deposited CL film comprises active catalyst layer 471 formed atop ionomer 454. Deposition of catalyst 471 formed atop the skeletal pillars 452 and 453 along with layer 471f deposited on frame 450, like 470f are electrically inactive. In FIG. 72, gas diffusion layers 472 and 473 are attached to the CCM while clamp 475 holds frame 450 resulting in the five layer MEA5 of FIG. 73.

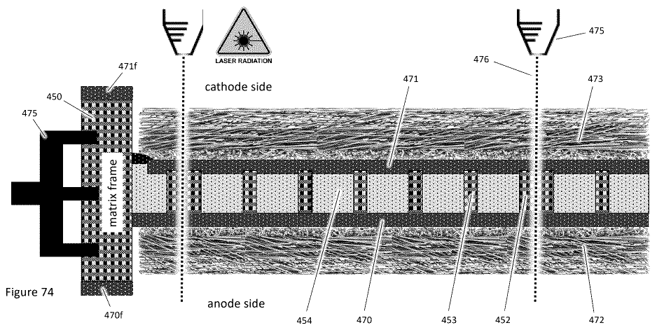

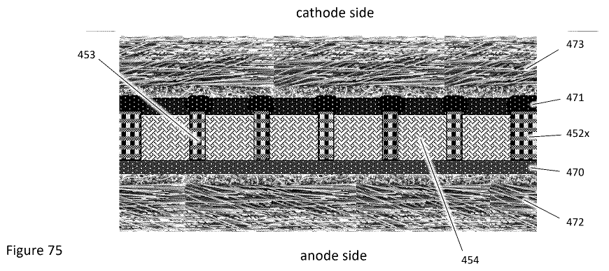

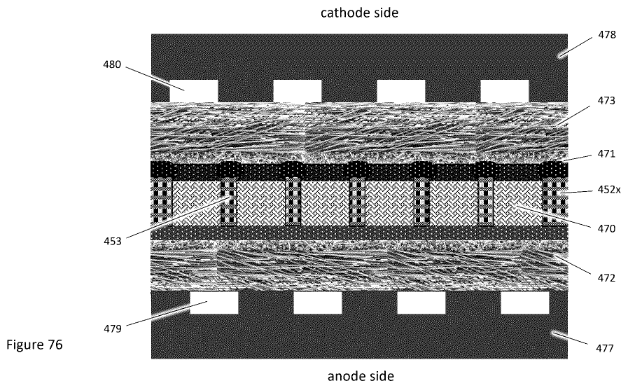

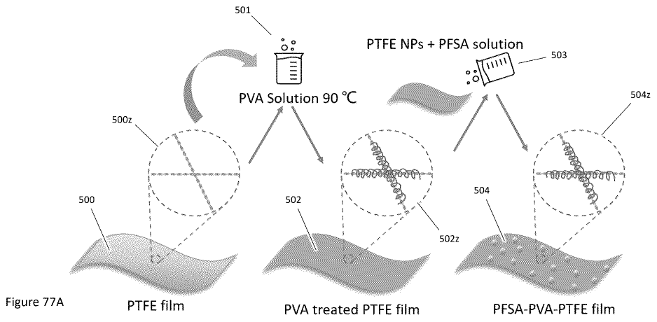

In FIG. 74, symmetric matrix frame 450 held by clamp 475 including IEM membrane 454 and integral skeleton elements 452 and 453 sandwiched by catalyst layers 470 and 471 and enclosed by GDL layers 472 and 473 are singulated by laser 475 along cut lines 476. The resulting singulated IEM is shown in FIG. 75. After attachment of bipolar layers 477 and 478 to GDL layers 472 and 473 respectively, the resulting seven layer MEA7 is shown in FIG. 76.

Regardless of whether the matrix frame is symmetrically or asymmetrically positioned around the membrane itself, or eliminated altogether, the concurrent fabrication of multiple IEMs using a batch process is beneficial as it reduces process variability, improves electrical and chemical consistency, increases production throughput, and lowers manufacturing cost. Beneficial embodiments of the inventive IEM fabrication methods using the inventive membrane matrix frame are numerous, including:
accurate control film thicknesses and dimensions via precision molds;
rigid skeletal support of ultra thin ionomeric membranes during manufacturing and operation;
rigid skeleton support including a peripheral exoskeleton and a thinner endoskeletal grid reduces film swelling from over hydration during operation;
ability to control skeletal and frame strength and rigidity using carbon fiber or other reinforcing materials such as carbon nanotubes, graphene, or fibrous plastics;
larger mechanical support frame for improved manufacturing by automated or robotic handlers;
matrix frame is capable of concurrently fabricating any number of IEMs including a matrix of rows and/or columns of IEMs bounded by a wider exoskeleton;
eliminates handling related film damage causing yield loss or latent reliability failures;
eliminates human contamination of films during assembly—clean room compatible;
able to support any ionomer including bulk conduction and surface conduction type;
consistent polymerization of ionomer under conditions of controlled pressure and temperatures;
capable of employing different materials on the anode and cathode of a CCM;
capable of attaching GDLs to the CCM prior to singulation eliminating the need to handle discrete IEMs during catalyst coating and during MEA5 fabrication, i.e. attaching the GDLs;
stress free laser singulation eliminates mechanical damage and tears in membranes; and
batch process capable of supporting high volume production at lower costs.

The methods as described are compatible with any type of ionomeric membrane including fluorocarbon and hydrocarbon chemistries, homo-ionomer or hetero-ionomer membranes, with or without skeletal support or nanocoatings. The methods may be used in conjunction with microporous membranes fabricated using a sacrificial filler process, and/or combined with permanent fillers comprising bismuth compounds, graphene oxides, pristine and functionalized carbon nanotubes, silicates, zeolite, zirconium, tungsten, nanofibers, nanospheres, MOFs, and POSS.

### Membrane Synthesis.

Although the process to fabricate the inert membrane matrix frame employs polymer chemistry relatively agnostic to the ionomer it supports, other embodiments involve the formation of the polymer itself. Ionomer chemistry depends on the conducting ion charge, either positively-charged ionized protons H⁺ or negatively-charged hydroxyl radicals —OH. As such, in a fuel cell two different charge transport polarities are possible. Positive charge conducting IEMs are referred to as cation exchange membranes or more commonly known as proton exchange membranes with the acronym PEM. Negative charge conducting IEMs are referred to as anion exchange membranes or AEMs.

The chemistry of the membrane and the catalyst also vary with the chemical source of the charge whether gaseous hydrogen, sodium hydroxide, acids, or glucose. While not all fuel cells produce carbon free byproducts, most fuel cells effluents comprise water, i.e. H₂O in liquid or vapor form. The presence of water in the fuel cell also affects the cell's operation either beneficially or to the detriment of its operating efficiency.

The electrochemistry of a fuel cell, using ionic transport through a membrane to create electricity is a generally reversible process in the cases of simple inorganic molecules such as hydrogen or hydroxide. This inverse process, making hydrogen from water or from alkaline water is referred to as electrolysis. The PEM and AEM membranes useful in fuel cells are generally also adaptable for use in electrolysis except that the membrane's area, chemistry, and catalysts may vary from their fuel cell counterpart.

Although glucose can be converted into electricity in a glucose fuel cell, the reverse process for electrolysis is not symmetric but instead converts glucose into hydrogen and various organic byproducts including commodity chemicals like sorbitol, 5-hydroxymethylfurfural, gluconic acid (GNA), and glucaric acid (GRA). GRA is considered a key intermediate for the production of biodegradable polymers and biodegradable detergents, as a metal complexation agent, and in pharmacology in chemotherapy and statin production.

The greatest commercial interest in ion exchange membrane is focused on hydrogen PEM fuel cells (H₂ PEMFCs) and in PEM-based direct methanol fuel cells (DMFCs) where the lion's share of content in the application is focused. Specific examples of PEM membranes fabricated for various use cases are described here below.

### Ionomeric PEM Fabrication.

In various embodiments of this invention, the fabrication of a PEM proton exchange membrane also referred to as a polyelectrolyte membrane involves a sequence of process steps that differ substantially from conventional membrane processing. The disclosed processes can be divided into two inventive methods—one synthesizing a surface conduction heterogenous ionomeric membrane, the other forming a homogenous bulk conduction ionomer whereby the primary difference is the way charge transport occurs. Either membrane formation method is compatible with the inert skeletal support structure described previously.

Specifically, the chemistry of forming a heterogenous PEM film is entirely dependent on the synthesis process required to form a resilient chemical bond between the hydrophobic backbone comprising an inert polymer such as PTFE and the hydrophilic ionomer involved in conduction. This process, can be achieved by co-polymerization, i.e. simultaneous formation of hydrophobic and hydrophilic elements bridged by an intervening sidechain pendant, or by ‘grafting’. In grafting a process for attaching sidechains to an inert long chain such as a PTFE backbone, the terminus of the sidechain comprises electrically active charge transfer molecules such as sulfonic acid, sulfonated pentablock terpolymers, and non-fluorinated ionomers such as sulfophenylated polyphenylene.

Unlike copolymerization which depends in the mutual compatibility of monomers and acid groups with cross-linking reagents and solvents during polymer formation, grafting depends on the chemistry of a molecular coating process performed subsequent to a membrane's structural synthesis. Simply put, in grafting a specific sequence of chemical reagents and/or radiation exposures are required to modify a hydrophobic backbone in order to graft a sidechain pendant and an associated hydrophilic ionomer onto its structure.

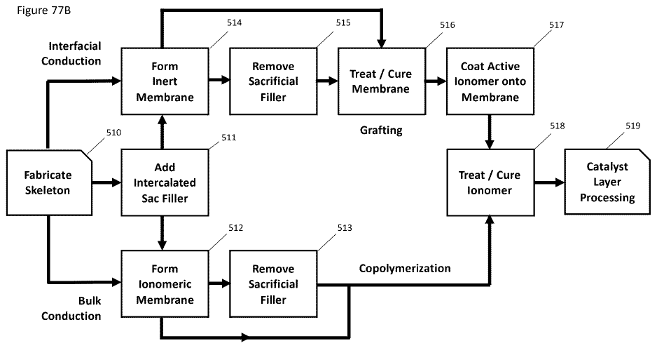

One exemplary process sequence is illustrated in FIG. 77A. As shown, after forming a PTFE supportive film 500 comprising molecular matrix 500z, the inert membrane is treated with reagents to facilitate bonding between the PTFE backbone and its hydrophilic pendant sidechains and ionomer. In one embodiment, polyvinyl alcohol, aka PVA solution 501 is used to treat the PTFE membrane. Having a molecular weight of 85,000-to-124,000, the PVA functions as an interfacial modifier. Polyvinyl alcohol, a water-soluble synthetic polymer [CH₂CH(OH)]ₙ or simply described as (C₂H₄O)ₓ can be formed by partially or completely hydrolyzing polyvinyl acetate. The conversion of the polyvinyl esters is usually conducted by base-catalyzed transesterification with ethanol via the reaction

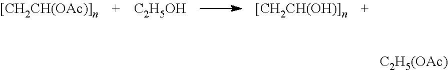

where the symbol OAc represents the molecule acetoxy, chemically as —OCOCH₃ and structurally as —O—C(═O)—CH₃ where the double bar symbol=means a double bond, not the equal sign in mathematical equation.

The properties of the resulting PVA polymer are affected by the degree of transesterification. PVA can be procured commercially in solution or made from PVA powder. For example, in small quantities PVA can be mixed by dissolving 4 g of PVA powder in 40 ml of deionized water and subsequentially mixed with a magnetic stirrer at 90° C. for 3 h until completely dissolved. In manufacturing, the solution can be purchased in volume and stirred at 90° C. immediately upon use.

The PVA treatment of the IEM matrix may be performed by immersing the fabricated membrane in the heated solution for between 3-to-24 hours. In one implementation made in accordance with this invention, the ion exchange membrane frame is occasionally removed from the PVA solution and rinsed in deionized water to remove any PVA particulates. As shown, the PVA treated PTFE film 502 comprises a coated hydrophobic backbone 502z to facilitate subsequent grafting to hydrophilic side groups of PFSA. The final PTFE thickness is then precisely controlled by a precision pressure mold, using a doctor blade process, or by the amount of material molded.

Thereafter in step 503 the membrane is spray coated with a PFSA solution comprising a solvent comprising a 1:1 weight percent ratio of deionized water and propanol mixed with a 0.5 weight percent of PTFE nanoparticles (NPs) to chemically neutralize the surface. The matrix frame is then held in a 60° C. oven for drying for approximately eight hours followed by a 150° C. anneal for thirty minutes resulting in PFSA-PVA-PTFE film 504 with polymerized microstructure 504z.

FIG. 77B represents an exemplary flow chart for fabricating ion exchange membranes made in accordance with this invention, with the resulting film comprising either interfacial or bulk conduction. The process commences with step 510 “Fabricate Skeleton” to produce an endoskeleton of semirigid pillars including wider exoskeletal elements used for IEM singulation by laser or mechanical cutting, and optionally a thick wide frame for mechanical or robotic handling during fabrication.

The next step 511 “Add Intercalated Sacrificial Layer” involves introducing a filler into the mold or cast such as sugar, chitosan, or other water or solvent soluble molecules to control film microporosity. The sacrificial filler may be introduced by blending the filler in solid form into a mix of monomers used to create the thin membrane or by dissolving the filler and monomers with a solvent into solution for casting. According to Miriam-Webster, the term intercalated means to “insert or position between or among existing elements or layers.” In the context of a molecular lattice of a polymer or crystal, the intercalated sacrificial filler represents a molecule temporarily occupying space within the lattice to reduce the atomic density of the polymer thereby increasing microporosity. Although the size of micropores affect transmembrane water transport in both interfacial and bulk conducting films, porosity has a more profound effect in bulk materials.

In the case of forming an interfacial conduction IEM, the sacrificial filler is mixed with monomers of an inert electrically-insulating material co-molded with the sacrificial layer using cast molding in step 514 “Form Inert Membrane” during which polymerization of the constituent monomers occurs via cross linking optionally aided by heating and/or mild pressure. During casting or molding, the sacrificial molecules becoming embedded into molecular matrix of the polymer or glassy polymer.

After cooling, the polymer is treated to dissolve and remove the sacrificial filler from the matrix using a corresponding solvent as depicted in step 515 “Remove Sacrificial Filler.” The film may be subsequently washed or cleaned in water or other solvents, soaked in solvents, and/or heated in step 516 “Treat/Cure Membrane” in order to prepare the semi-insulating membrane for a subsequent coating step to enable electrical conductance.

In step 517 “Coat Active Ionomer onto Membrane,” the insulating polymeric substrate is coated with a conducting ionomer which bonds to surface of polymer strands either through surface tension or covalent bonding, thereby grafting hydrophilic functional groups such as sulfonic or phosphonic acid onto the polymer chains. The details of the graft or bond depend on the process used in preceding step 516.

Bonds for example may between the mainchain and a sidechain or pendant molecule may occur by various mechanisms including (i) attachment at a damage site created by a chemical reagent or by radiation treatment; (ii) attachment by a chemical substitution reaction where one or more atoms of the mainchain become replaced, e.g. substituting fluorine with carbon or oxygen to enable covalent bonding between the polymer backbone and sidechains; (iii) entanglement where one end of the sidechain becomes physically enveloped, i.e. tangled, with the 3D structure of the polymer's mainchain tethering the sidechain pendant and its acid terminus to the membrane's molecular matrix; or (iv) intertwining, where the molecular strands of two polymers, one inert and hydrophobic, the other hydrophilic and bonded to ionomeric termini, become so entwined they cannot be separated or untangled. Despite their repulsive forces, hydrogen bonding and Van der Waals forces occurring intermittently along the chains prevent the two incompatible chains from unwinding and dissociating.

In other cases, a cross linking agent such polydopamine or glutaraldehyde can secure the molecular structures to one another. In the special instance of inserting conductive ionones into the mainchain itself rather than by attaching a sidechain, the mainchain must be cleaved or severed to accommodate the insertion, a physical chemical process analogous to the way an endonuclease can sever deoxyribose in biochemistry.

Regardless of the molecular bonding mechanism in step 517 “Coat Active Ionomer onto Membrane,” the terminology does not simply mean to coat the exterior face of the membrane with an ionomeric coating but to encase the individual strands of the hydrophobic polymeric strands with a sheath of conducting sidechains and acids. The conductive encasement formed by the molecular coating process, analogous to myelin coating of nerves or insulation coating a wire, enables conduction along the length of the hydrophobic polymer strands, in essence forming surfaces for surface conduction within the polymeric or glassy matrix of the membrane.

Step 517 may also include introduction of a solute matrix of nanoparticles carried by a solvent. For example if the inert structural matrix formed in step 514 comprises PTFE and the monomers introduced in coating step 517 is a spray or solution of PTFE, PFSA and PVA, then in step 518 “Treat/Cure Ionomer” a thin layer of conductive channels of PFSA ionomeric conductors is formed along the spine of the PTFE mainchains. To strengthen the bonds, the PTFE membrane or skeleton is sprayed with PVA, washing the film with ethanol, then stimulating cross linking to the polytetrafluoroethylene surface using glutaraldehyde. Alternatively PVA may be cross linked to poly(acrylic acid-co-2-acrylamido-2-methyl propane sulfonic acid), chemically as (P(AA-AMPS)), to enhance stability.

In other variants, the polymer may comprise or fluorocarbons forming glassy matrices or may comprise low-fluorine or fluorine-free compounds. For example, other composite membranes made in accordance with this invention involve bonding using PVA with inorganic zirconium phosphate to form a highly-stable composite membrane of PTFE-ZrP-PVA. Thereafter, the film is ready for subsequent CCM processing in step 519 “Catalyst Layer Processing.” The resulting structure is an endoskeletal-supported composite reinforced membrane CRM which primarily conducts ions via ionomer pendants such as PFSA adhering to and attached along the PTFE chain.

The resulting ionomer is therefore a heterogenous film and IEM. Fabricating a bulk conducting film is also represented in the same flow chart commencing with formation of the skeletal support in step 510 to produce an endoskeleton of semirigid pillars including wider exoskeletal elements used for IEM singulation by laser or mechanical cutting, and optionally a thick wide frame for mechanical or robotic handling during fabrication. The next step entitled “Add Intercalated Sacrificial Layer” involves introducing a filler into the mold or cast such as sugar, chitosan, or other water or solvent soluble molecules to control film microporosity.

The sacrificial filler is then mixed with monomers of a hydrophilic electrically-conductive ionomeric material co-molded with the sacrificial filler using pressure or thermal cast molding in step 512 “Form Ionomeric Membrane.” In this process, also referred to as co-molding the sidechain and the mainchains are formed concurrently and covalently bound during the polymerization process. By integrating two hetero-monomer segments, i.e. a di-monomers, alternating between pristine hydrophobic mainchain segments and those containing sidechain pendants with hydrophilic ionomeric termini, the ionomer's equivalent weight (EW), i.e. the mole fraction of conductive ionomer groups, can be regulated.

For example, the ionomers Nafion®, Aquivion®, 3M™, etc. comprise PFSA-PTFE di-polymer formed by a linear mainchain of hydrophobic TFE segments of (—CF₂—CF₂—) alternated with a second monomer having a single oxygen substitution of fluorine, namely (—CFO—CF₂—) where the oxygen forms a second bond with a sidechain pendant with a hydrophilic ionomer terminus. The equivalent weight (EW) is defined as the number of grams of dry polymer per mole sulfonic acid (SO₃) determined by the average distance between the side chains along the backbone, i.e. the occurrence frequency of the second monomer segment. Commercial equivalent weights range from 700 to 1200 for the PFSA class of fluorocarbon based membranes. The combination of a long inert mainchain with multiple sidechain pendants is sometimes referred to as a ‘comb’ polymer because of its structural shape.

Partially fluorinated membranes include segments containing glass like compounds rather than PTFE. Examples include hydrolyzed perfluoro-(2,2-dimethyl-1,3-dioxole) (PDD) and poly(perfluoro-2-methylene-4-methyl-1,3-dioxolane) (PFMDD). Di-monomer based membranes also are common in hydrocarbon based polymers include polyethylene (PE), polyvinyl chloride (PVC), phenylsulfonyl-poly(benzoyl-phenylene) (PhSO)P(BzPh); poly phosphazene P(Pz); and poly siloxane P(Sx). Other forms of polymers contain multiple dissimilar segments on their mainchain. Examples include hybrid heteropolymers of hydrocarbons such as poly arylene ether sulfone (PAES, PAESf), poly arylene ether matrix (PAEM); poly(ether ketone) (PEK), poly(ether sulfone) (PES, PESf); poly(ketone sulfone) (PKS, PKSf); poly(arylene ketone ether sulfone) (PAKES, PAKESf); and poly(arylene ether sulfone) triazine bisphenol (PAES)(TzBPh).

A large class of copolymers employs linking molecules to complete a heterogenous mainchain or cross-linked chains. Examples include a large number of poly vinyl difluoride compounds (PVDF-co-X) where X may represent any number of monomeric segments including perfluorostyrene, polyphenylene quarter-Ph, polyamide sulfonimide, polyvinyl alcohol, PVP polystyrene, F₆ propylene, and others. A key element to the assembly of copolymers is the inclusion of amphiphilic molecules to facilitate linking. An amphiphilic or amphiphatic molecule is one having both hydrophobic (nonpolar) and hydrophilic (polar) regions to facilitate bonding. One other class of copolymer comprises large subunits known as blocks assembled in a linear sequence, often with amphiphilic linkers contained within.

Returning to FIG. 77B, following polymerization in step “Form Ionomeric Membrane” in step 512, the sacrificial filler is dissolved and removed in step 513 “Remove Sacrificial Filler” using a corresponding solvent. For example if the sacrificial filler is sugar, the solvent may be water. The film may be subsequently washed or cleaned in water or other solvents, soaked in solvents, and/or heated in step 518 “Treat/Cure Ionomer” in order to strengthen the PFSA bonds within the polymer and between the ionomer and the skeleton. In this process the PTFE membrane or skeleton is sprayed with PVA, washing the film with ethanol, then stimulating cross linking to the polytetrafluoroethylene surface using glutaraldehyde. Alternatively PVA may be cross linked to poly(acrylic acid-co-2-acrylamido-2-methyl propane sulfonic acid), chemically as (P(AA-AMPS)), to enhance stability in preparation for catalyst layer formation in step 519.

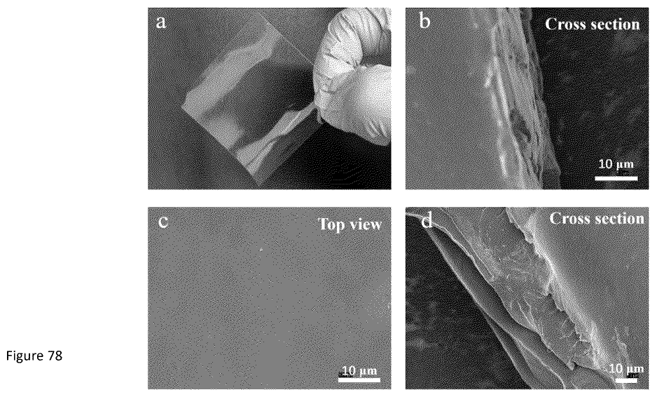

Exemplary films made in accordance with this invention are shown in the samples shown in FIG. 78 including (a) photo, (b) cross section, (c) top view, and (d) alternative cross section. Exemplary test devices confirm the benefit of scaling the PEM membrane thickness in a surface conducting ionomer fuel cell. After synthesis, the fabricated membranes were assembly into a single layer fuel cell assembly and electrically characterized.

### PEM Measured Electrical Characteristics.

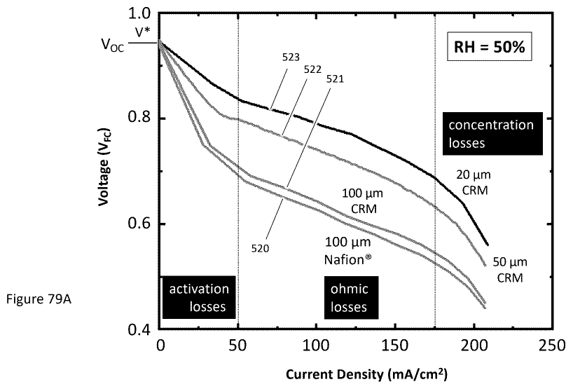

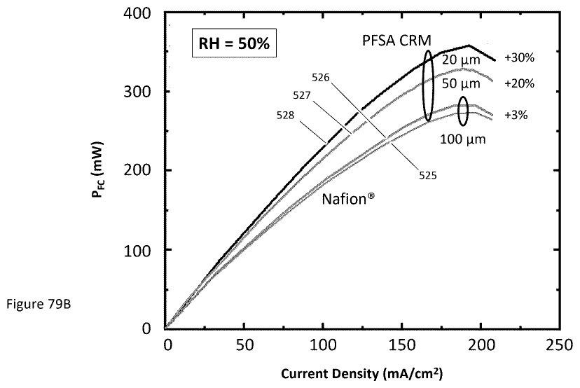

As shown in FIG. 79A, a lab fabricated test PEM comprising a composite PFSA-PVA-PTFE composite reinforced membrane (CRM) of 100 μm thickness exhibits a voltage-current characteristic curve 521 at a relative humidity of 50%. This electrical characteristic 520, sometimes referred to as a polarization curve exhibits slightly better characteristics than curve 520 measured on a Nafion® based fuel cell of the same thickness. Scaling a CRM reinforced composite membrane to thinner film thickness beneficially improves conductance as shown by curve 522 for a 50 μm PEM and curve 523 for a 20 μm PEM.

Multiplying the conducted current density value times the measured cell voltage results in the power density curves shown in FIG. 79B exhibiting peak power at around 200 mA/cm² at RH=50%. These curves include conventional Nafion® PEM characteristic 525 and CRM curve 526 both comprising 100 μm films CRM curves 527 at 50 μm and 528 at 20 μm exhibit 20% and 30% higher power densities respectively than conventional PEM curve 525, peaking at a measured power 350 mW corresponding to a membrane conductivity of 45 mS/cm. At RH=100%, the conductance improves to 85 mS/cm.

Scaling the membrane's active area to mA_{FC}=120 cm² means a fabricated cell using the fabricated film will deliver 12 W at a current of 24 A and a cell voltage of V_{FC}=0.5 V. The described CRM fabrication process demonstrated does not include any provisions for enhancing the porosity of the PTFE web-like framework reinforcing the film nor does it include the semi-rigid skeleton disclosed previously.

Use of the term “polarization curves” to describe the voltage-current characteristics of a fuel cell is a bit misleading as not all the electrical effects in a fuel cell relate to polarization related losses. Some effects, for example ohmic losses occurring in conductors such as the bipolar plates, are in fact not related to polarization while other loss mechanisms are. More broadly the losses can be categorized into four components—a lossless polarization voltage V*, activation losses, ohmic losses, and concentration or transport losses.

The lossless component V* represents the zero current voltage differential between the ideal cell voltage V_{chem} and the fuel cell's open-circuit terminal voltage V_{FC}(I=0⁺)=V_{OC} at the onset of conduction. This voltage differential is similar to a contact potential. Since this V* potential is overcome electrostatically, i.e. requiring no DC current, the voltage V_{chem} is not meaningful in calculating efficiency of a fuel cell membrane or in power losses. Instead the open circuit voltage V_{OC} neglecting the lossless component V* is a better reference when calculating efficiency. As such, the fuel cell efficiency can be calculated by η_{FC}=V_{FC}/V_{OC} where the fuel cell voltage is a function of current, temperature, and relative humidity V_{FC}=f (I_{FC}, T, RH). Importantly, by maintaining temperature and relative humidity, a membrane's polarization curve allows extraction of numerous electrical properties of an ion exchange membrane including power output, conversion efficiency, heat generation, resistance and resistive losses, activation losses, and the onset of high current concentration losses.

Specifically the power generated by the fuel cell is given by the fuel cell's voltage V_{FC} at a specified current whereby P_{FC}=I_{FC}V_{FC}. The power output can be converted into power density by dividing its current I_{FC} by the fuel cell's active area A_{FC} in which power density in mW/cm² is calculated as (P_{FC}/A_{FC})=[I_{FC}/A_{FC}](V_{FC}) where V_{FC} is a function of current density. Similarly power input to a fuel is given by its open circuit voltage V_{OC} multiplied by its current I_{FC} or current density I_{FC}/A_{FC}, as given by either Pᵢₙ=I_{FC}V_{OC} or by (Pᵢₙ/A_{FC})=[I_{FC}/A_{FC}](V_{OC}) where V_{OC}=V_{eff}=V_{chem}−V* and where V* is the voltage drop due polarization at I_{FC}=O⁺.

As defined thermodynamically or electrodynamically, conversion efficiency η_{FC} of a fuel cell is defined as its by the power output V_{FC} divided by its power input Pᵢₙ or simply η_{FC}=P_{FC}/Pᵢₙ=V_{FC}/V_{OC} where P_{FC} and V_{FC} are a function of I_{FC} or I_{FC}/A_{FC}. The resulting equation if current in amperes (A) is replaced by current density in mA/cm². In other words, the efficiency of a fuel cell at a specific current or current density is the ratio of its measured voltage to the open circuit voltage. For example, for Nafion® polarization curve 520 operating at a current density of 50 mA/cm² the fuel cell voltage is measured to be V_{FC}=0.67V while the voltage at I_{FC}=0⁺ is V_{OC}=0.94V. Substituting the measured values into the expression, the corresponding empirical efficiency as defined by the ratio of the two is thereby η_{FC}=P_{FC}/Pᵢₙ=V_{FC}/V_{OC}=(0.67V)/(0.94V)=71% whereby activation losses are (100%—η_{FC})=(100%−71%)=29% The activation voltage ΔVₐ=V_{OC}—V_{FC}=0.94V−0.67V=0.27V.

In direct comparison, the polarization curves of fuel cells comprising membranes made in accordance with this invention include 100 μm composite reinforced membrane (CRM) shown by curve 521 with V_{FC}=0.72V, an activation voltage ΔVₐ=V_{OC}−V_{FC}=0.94V−0.72V=0.22V and a corresponding loss of (1−η_{FC})=1−(0.72V)/(0.94V)=(100%−77%)=23%. Because the membrane is reinforced it can be scaled to higher performing thinner membranes. For example, curve 522 for a 50 μm film exhibits a voltage at 50 mA/cm² at V_{FC}=0.80V, an activation voltage ΔVₐ=V_{OC}−V_{FC}=0.94V−0.80V=0.14V and a corresponding loss (1−η_{FC})=1−(0.80V)/(0.94V)=(100%−85%)=15%. By comparison, curve 525 for a 20 μm film exhibits a voltage of V_{FC}=0.83V, an activation voltage ΔVₐ=V_{OC}−V_{FC}=0.94V−0.83V=0.11V and a corresponding loss (1−η_{FC})=1−(0.83V)/(0.94V)=100%−88%=12%.

As demonstrated in the below table activation voltage of membranes made in accordance with this invention improved by 2.7× reducing from 270 mV and a 29% power loss to 110 mV with only a 12% power efficiency reduction. Because of the reduced activation loss, the membrane resistance R_{memb} averaged across the ohmic region decreases from 2.5 Ωcm² down to 1.4 Ωcm².

| Membrane | V_{FC} @ 50 mA/cm² | Activation ΔVₐ | 1 − η_{FC} | Ohmic R_{memb} @ I_{FC}/A_{FC} = 175 mA/cm² |
|---|---|---|---|---|
| 100 μm Nafion | 0.67 V | 270 mV | 29% | R = (0.94 V-0.50 V)/(I_{FC}/A_{FC}) = 2.50 Ωcm² |
| 100 μm CRM | 0.72 V | 220 mV | 23% | R = (0.94 V-0.53 V)/(I_{FC}/A_{FC}) = 2.30 Ωcm² |
| 50 μm CRM | 0.80 V | 140 mV | 15% | R = (0.94 V-0.63 V)/(I_{FC}/A_{FC}) = 1.8 Ωcm² |
| 20 μm CRM | 0.83 V | 110 mV | 12% | R = (0.94 V-0.69 V)/(I_{FC}/A_{FC}) = 1.4 Ωcm² |

As evidenced by a change in slope, above current densities of 50 mA/cm², DC losses are primarily ohmic in nature including the chemical diffusion resistance involving cation conduction across the membrane and purely resistive losses for conducting electrons out of the fuel cell or fuel cell stack. At higher currents, e.g. over 175 mA/cm² “concentration losses” begin to impede carrier transport including water logging, membrane swelling, and other transport effects.

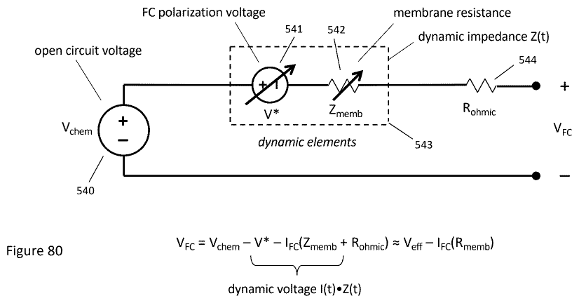

The overall electrical behavior can be modelled as a lumped element model shown in FIG. 80 comprising open circuit voltage 540 of magnitude V_{chem} is series with a current-dependent counter-opposing voltage source 541 modelling chemical polarization effects of magnitude Vₚₒₗ, a current dependent membrane impedance 542 of magnitude Z_{memb} with a real component Re{Zmemb} representing dynamic membrane resistance R_{memb}, and a constant ohmic resistance 544. In this manner the terminal voltage of a fuel cell can be expressed as by the equation

$${V}_{FC} = {V}_{chem} - {V}_{pol} - \vert \cdot ( {Z}_{memb} + {R}_{ohmic} ) \approx {V}_{eff} - \vert \cdot ( {R}_{memb} )$$

where the dynamic impedance 543 of magnitude Z(t) is given by

$$Z ( t ) = \frac{{V}^{*}}{I} + {Z}_{memb}$$

and where real components V_{eff}≈V_{chem}−V* and R_{memb}=Re {Z_{memb}}>>R_{ohmic}. The ideal FC voltage 540, FC polarization voltage V*, and DC membrane resistance 102 are all functions of temperature T, relative humidity of the anode RH_{A}, relative humidity of the cathode RH_{C}, and current density I/A.

Even at zero current when resistive losses are diminutive, the fuel cell voltage V_{FC} still remains less than the electrochemical potential V_{chem} because of contact potential, i.e. the work function between dissimilar materials present in the cell's construction. As such, a fuel cell cannot deliver any power at the voltage V_{chem}. More precisely, the maximum possible voltage of an unloaded fuel cell is given by V_{FC}=V_{chem}−V* where V* the minimum polarization voltage is non-zero.

### Bulk Conducting Ionomer PEM.

Another approach to forming a PEM membrane made in accordance with this invention is to employ a homogenous ionomer with added support in the active conducting areas. While pure ionomeric films suffer from swelling and risk mechanical damage during handling, in one embodiment of this invention the combination of the disclosed semi-rigid skeleton with a bulk conducting ionomer provides the complementary advantages of both mechanical support and high film conductivity not achievable by CRMs.

Note that for an ion-conduction mechanism in which water is the transport medium, even very thin hydrophobic barriers can drastically reduce ion conductivity. Accordingly, to overcome this problem, made in accordance with this invention the bulk conducting membrane includes narrow water channels called nanopores to enhance ion transport under low humidity conditions.

Accordingly, the disclosed bulk conducting membrane comprises a pure PFSA polymer with increased porosity. In one embodiment the enhanced porosity film is formed using a sacrificial filler interspersed within the PFSA matrix. To open pores within the ionomeric polymer, the filler must be present in the dispersion cast or mold at the time of PFSA formation. At the time of polymerization the filler occupies spaces where PFSA monomers would otherwise occupy. After the matrix is polymerized, the filler is removed using any solvent that does not dissolve PFSA. After the filler is dissolved and removed by the solvent, the resulting membrane is washed of any remaining reagents in deionized water and dried. In the spaces of the polymerized matrix the filler previously occupied, now a thermally stable nanopore remains increasing the ionomer's porosity and enhancing proton transport.

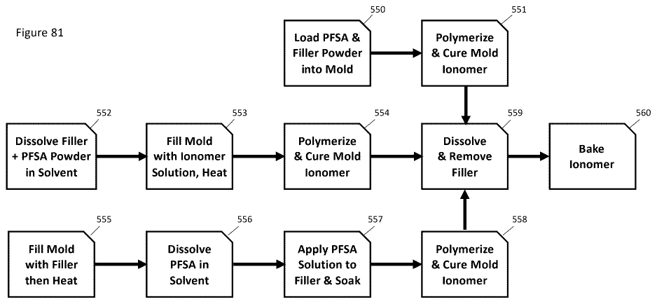

As depicted in the flow chart of FIG. 81, the fabrication sequence for a porous PEM film may vary. In one instance the filler may be mixed together with the ionomer as a solid powder and loaded into a mold 550. The mixed compound is then polymerized and cured with heat and/or pressure 551. In another version the PFSA powder is mixed with filler and dissolved in solution 552. The ionomer solution is then filled into the mold 553 and heated to dry out the film before it is polymerized and cured with heat and/or mild pressure 554. In another implementation, the filler loaded into the mold in either solid or dissolved form and heated 555 to form a weakly crystalized substrate or quasi-template.

The PFSA is then dissolved in a solvent 556 and applied onto the crystalized substrate of the filler 557 giving time for the PFSA to soak into the filler crystal. Once thoroughly wetted, the ionomer is baked then polymerized and cured with heat and/or pressure 558. During molding and curing in either steps 551, 554, or 558 the polymer forms in and around the filler. The filler is then subsequently dissolved and removed by a solvent in step 559 followed by a final stabilizing bake 560.

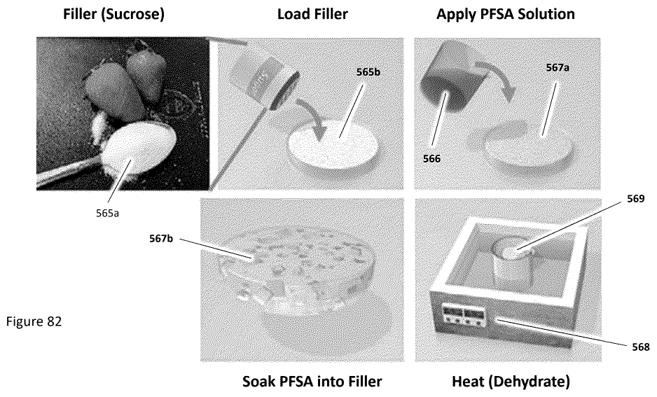

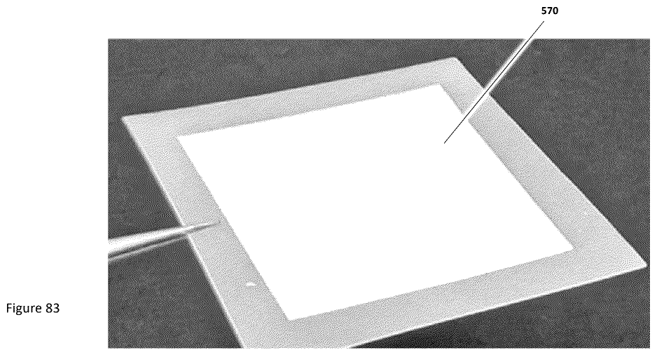

For illustrative purposes FIG. 82 details a demonstration involving sucrose 565a, i.e. granulated sugar (strawberries not included) loaded into petri dish as the filler 565b. The fine granulated crystal sugar comprise sucrose particles ranging in size between 100 nm to 1 μm. PFSA powder dissolved in solution, e.g. using a mix of one part deionized water and one part propanol (1:1 by weight percent), was then poured into the mold containing the sucrose.

The mixtures were settled for at least 8 h to allow the PFSA solution precursor to fully infiltrate the pores of the sugar template. After curing, the PFSA was subjected to a water bath (at the temperature of 60° C.) in order to dissolve the sugar filler. The porous PFSA film was air dried at 60° C. for half an hour and then carefully detached from the glass substrates and thermally annealed at 150° C. for 30 min to complete the fabrication process.

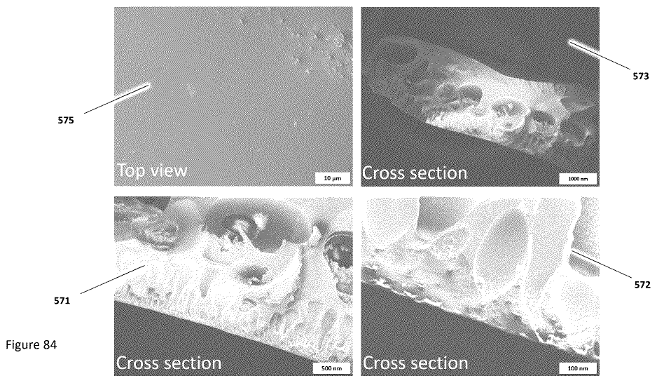

The exemplary films fabricated through this process comprise a white porous film 570 shown in FIG. 83 having dimensions 5 cm×5 cm or mA_{FC}=25 cm² and of thickness 20 μm with an average porosity of 0.6 as shown in FIG. 84. Observed pore size varied by orientation within the film. As measured by scanning electron microscopy (SEM), pore sizes having dimensions comprising 100 nm, 500 nm, and 1 μm corresponding to images 571, 572, 573 were fabricated and optically and electrically characterized. These porous PEM films cross sections are contrasted against a PEM top view 575.

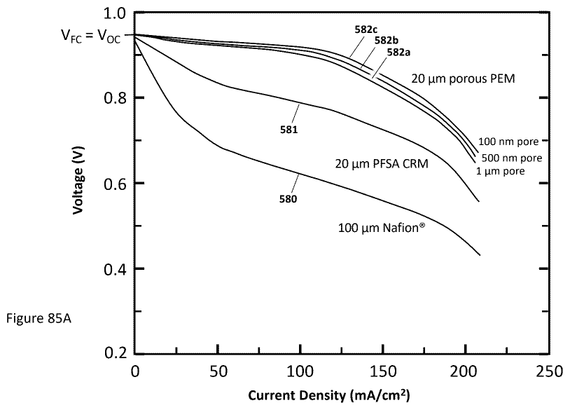

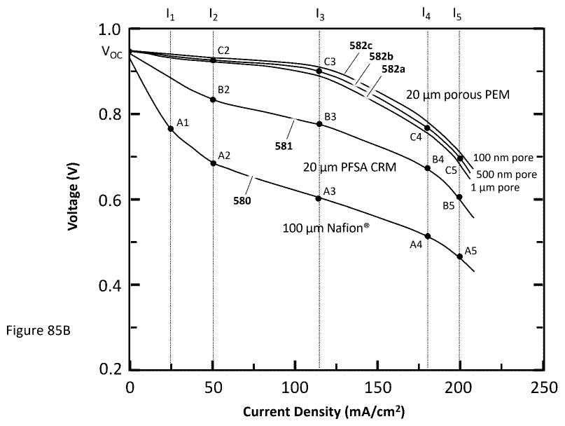

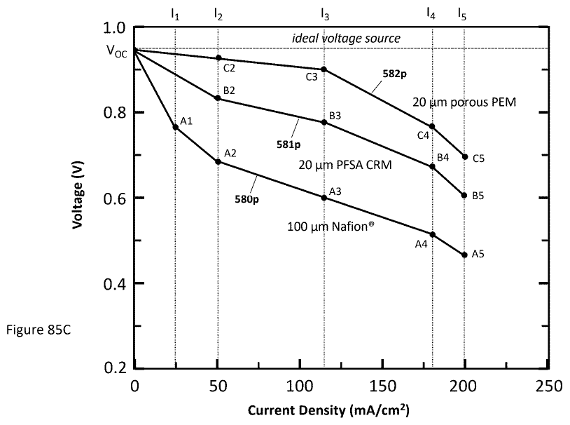

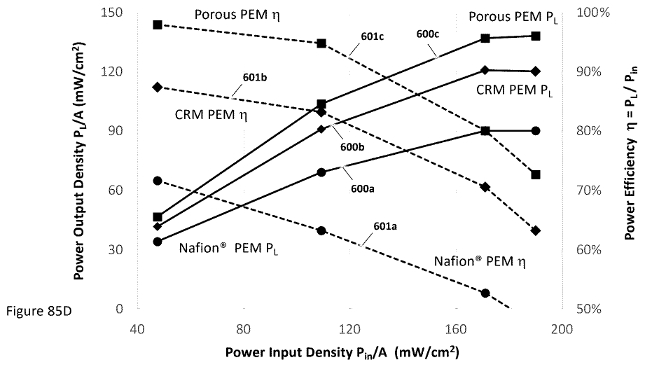

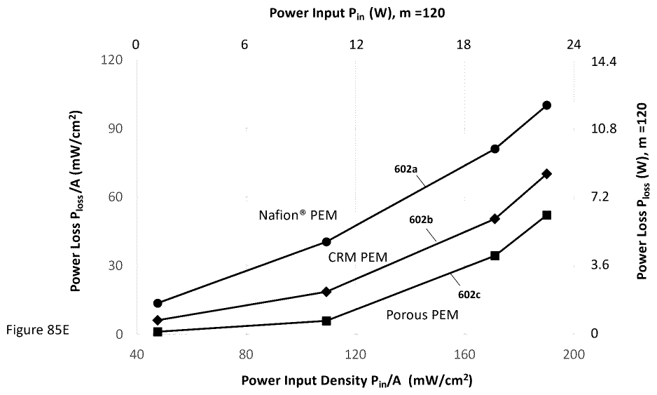

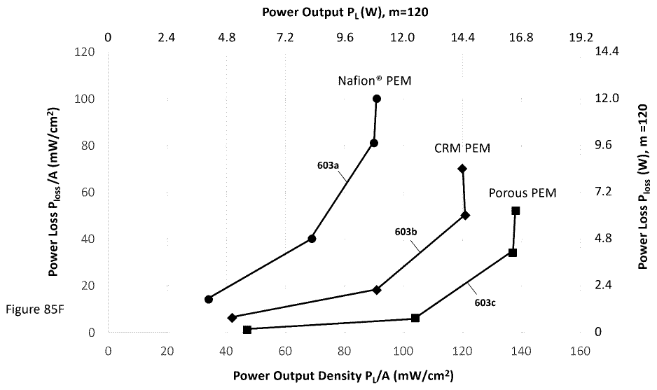

The voltage-current relationship of fabricated porous PEM films 582a, 582b, and 582c is contrasted in FIG. 85A against that of aforementioned 20-μm PFSA-PVA-PTFE composite reinforced membrane CRM 581 and 100 μm Nafion® film 580. As shown, all three porous 20 μm thick PEM films 582a with 1 μm pores, 582b with 500 nm pores, and 582c with 100 nm pores significantly outperform both the 20 μm PFSA-PVA-PTFE composite reinforced membrane CRM 581 and the 100 μm Nafion® film 580. Benefits include less voltage sag, lower membrane resistance, operation to higher current densities, and most notably a significant reduction in activation losses.

Although numerous models exist to theoretically predict PEM polarization curves, since we already have measured electrical characteristics, fuel cell parameters can be extracted using a simplified piecewise linear resistance model assuming a fixed zero open circuit polarization voltage of V*=V_{chem}−V_{OC} where V_{OC} is the open circuit voltage at the onset of conduction. According to the previously shown graph of FIG. 85A the open circuit voltage V_{OC}=0.94V.

If we assume the intrinsic electrochemical fuel cell voltage is V_{chem}=1.2 V, then V*=V_{chem}−V_{OC}=1.2V−0.94V=0.26V. Since this voltage drop occurs at nearly zero current, it dissipates no power and therefore can be ignored in power and efficiency calculations. Instead the value V_{OC}=0.94V should be considered the ideal fuel cell voltage by which power loss is calculated regardless of what V_{chem} is. Accordingly the terminal voltage of the fuel cell as a function of current can be estimated using an effective average resistance R_{eff} by the equation

$${V}_{FC} = {V}_{OC} - {I}_{FC} {R}_{eff}$$

with a corresponding power P_{L} delivered to a load given by

$${P}_{L} = {I}_{F C} ( {V}_{OC} - {I}_{FC} {R}_{eff} ) = {I}_{FC} {V}_{OC} - {I}_{FC}^{2} = [ {P}_{100} - {I}_{FC}^{2} {R}_{eff} ] = {P}_{100} - {P}_{loss}$$

where the ideal fuel cell power at one-hundred percent efficiency is given by P₁₀₀=I_{FC}V_{OC} when the current I_{FC}=0, where R_{eff} is the average resistance defined by R_{eff}=(V_{OC}−V_{FC})/I_{L}, and where the average power loss Pₗₒₛₛ dissipated within the fuel cell is Pₗₒₛₛ=I_{FC}² R_{eff}.

A more accurate description of power loss is a piece wise linear model where the total energy lost is determined by a current dependent variable resistance Rₓ where

$${P}_{L} = {I}_{FC} {V}_{OC} - {P}_{loss} = {P}_{100} - {P}_{loss}$$

$${P}_{loss} = {I}_{1}^{2} {R}_{1} where {R}_{1} = {V}_{1} / {I}_{1} for {I}_{FC} \leq {I}_{1}$$

$${P}_{loss} = {I}_{1}^{2} {R}_{1} + ( {I}_{2}^{2} - {I}_{1}^{2} ) {R}_{2} where {R}_{2} = ( {V}_{2} - {V}_{1} ) / ( {I}_{2} - {I}_{1} ) for$$

$${I}_{1} < {I}_{FC} \leq {I}_{2}$$

$${P}_{loss} = {I}_{1}^{2} {R}_{1} + {I}_{2}^{2} {R}_{2} + ( {I}_{3}^{2} - {I}_{2}^{2} ) {R}_{3} where {R}_{3} = ( {V}_{3} - {V}_{2} ) / ( {I}_{3} - {I}_{2} ) for$$

$${I}_{2} < {I}_{FC} \leq {I}_{3}$$

$${P}_{loss} = {I}_{1}^{2} {R}_{1} + {I}_{2}^{2} {R}_{2} + {I}_{3}^{2} {R}_{3} + ( {I}_{4}^{2} - {I}_{3}^{2} ) {R}_{3} where$$

$${R}_{4} = ( {V}_{4} - {V}_{3} ) / ( {I}_{4} - {I}_{3} ) for {I}_{3} < {I}_{FC} \leq {I}_{4}$$

and so on. As a discrete series summation Pₗₒₛₛ can be expressed as

$${P}_{loss} = {\sum }_{0}^{n} [ {I}_{x}^{2} - {I}_{( x - 1 )}^{2} ] {R}_{x}$$

for where I₍ₓ₋₁₎<I_{FC}≤Iₓ and where Rₓ is the small signal resistance Rₓ=(Vₓ−V₍ₓ₋₁₎)/(Iₓ−I₍ₓ₋₁₎). The power delivered to the load is given by

$${P}_{L} = {I}_{FC} {V}_{OC} - {P}_{loss}$$

whereby Pᵢₙ=P_{L}+Pₗₒₛₛ=I_{FC}V_{OC} or more specifically

$${P}_{100} = {P}_{L} + {P}_{loss} = {V}_{OC} {I}_{FC} + {\sum }_{0}^{n} [ {I}_{x}^{2} - {I}_{( x - 1 )}^{2} ] {R}_{x}$$

The efficiency is then given by

$$η = \frac{{P}_{L}}{{P}_{in}} = \frac{{P}_{L}}{{P}_{L} + {P}_{loss}} \approx \frac{{V}_{OC} {I}_{FC}}{{V}_{OC} {I}_{FC} + {I}_{FC}^{2} {R}_{eff}} = \frac{{V}_{OC}}{{V}_{OC} + {I}_{FC} {R}_{eff}}$$

To analyze the fuel cell performance, the electrical curves are converted in FIG. 85B by adding current lines I₁, I₂, I₃, I₄, and Is with corresponding data points A₁, A₂, B₂, B₃, C₃, A₄, B₄, C₄, A₅, B₅, and C₅. For simplicities sake, the curves are converted into piecewise linear resistances R₁ through R₅.

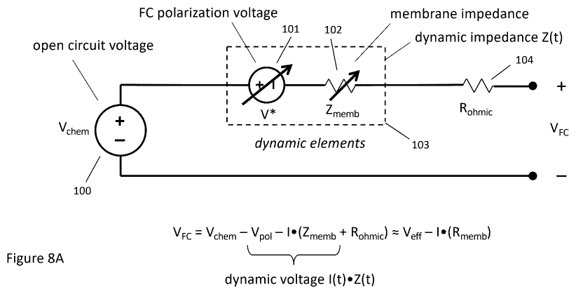

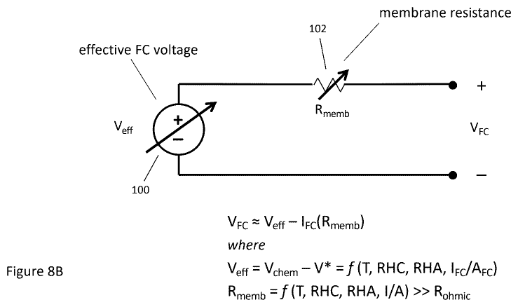

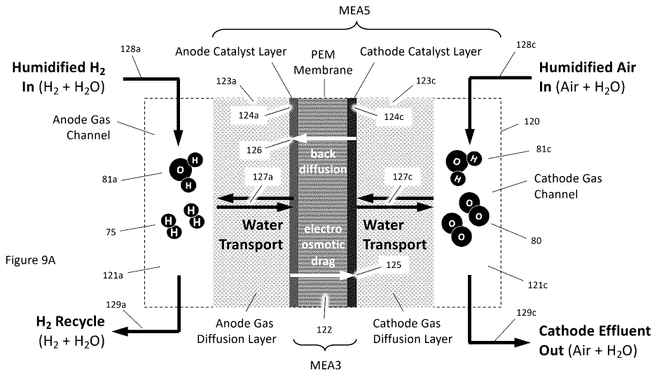

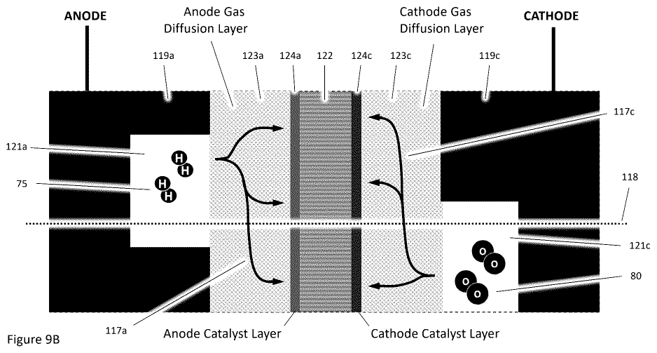

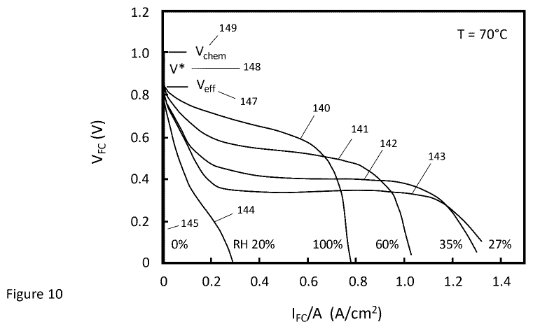

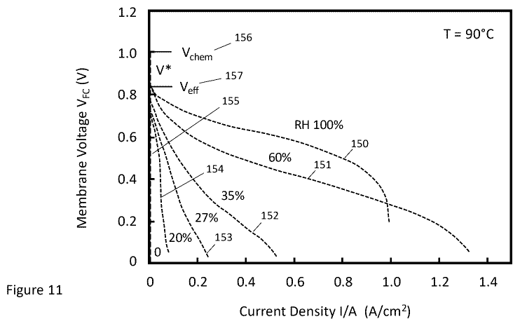

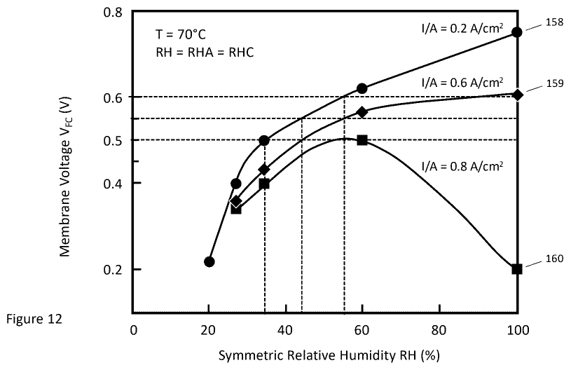

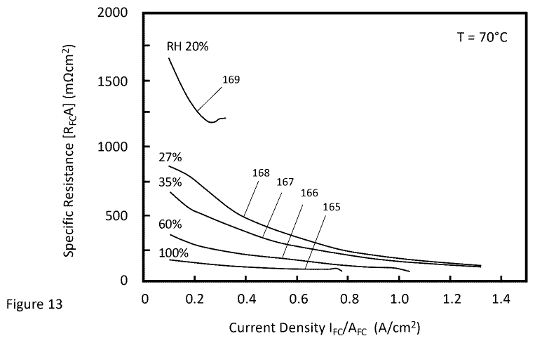

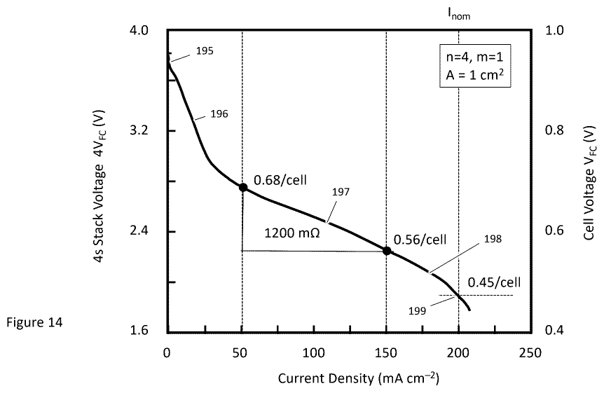

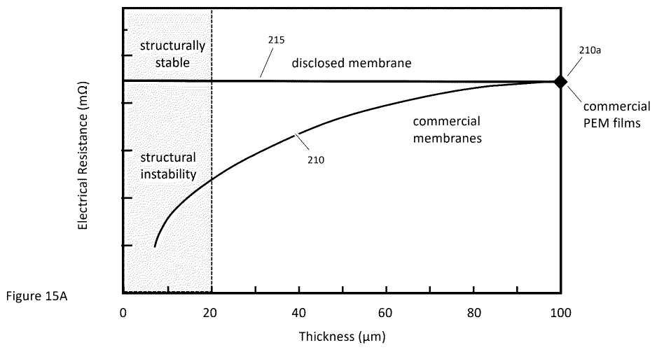

The piecewise linear resistance occurring in the ohmic region of operation may also be considered as have a small signal differential resistance denoted by the lower case variable rₛₛ where “ss” means small-signal or differential resistance. Differential resistance rₛₛ may be considered as the partial derivative of voltage with respect to current for operation ∂V/∂I within the ohmic operational region irrespective of the polarization voltage V*. Referring to the previous illustration FIG. 8A, differential resistance rₛₛ may a component of membrane impedance Z_{memb} 102 which may include various frequency dependent mechanisms, e.g. the relaxation time needed for an ion to bond to an ionomer and then be released, or the average collision time between water and protons in the polymeric matrix, including the formation and dissociation of hydronium ions.

In FIG. 85C, the curves are converted into straight line segments 580p, 581p ands 582p so that the resistances Rₓ can easily be estimated from measured data. In the following table power is measured in mW and normalized by area. Note the small resistance may be greater or small than the average DC resistance depending on the membrane and current density. For example at point A3 the average resistance R_{FC}=3 Ωcm² while the small signal resistance rₛₛ is only 1.2. Ωcm². Conversely, around point B5 the differential resistance rₛₛ=3.5 Ωcm² while the average DC resistance is lower, having a value R_{FC}=1.8 Ωcm². In general, for power calculations the DC value is more meaningful while for transient and AC behavior the small signal resistance is more relevant.

| | X | Iₓ/A | Vₓ | X − 1 | Iₓ₋₁/A | Vₓ₋₁ | Pᵢₙ/A | R_{FC} | P_{L}/A | Pₗₒₛₛ/A | η | rₛₛ |
|---|---|---|---|---|---|---|---|---|---|---|---|---|
| | Units: | | | | | | | | | | | |
| Membrane | — | mA/cm² | V | — | mA/cm² | V | mW/cm² | Ωcm² | mW/cm² | mW/cm² | % | Ωcm² |
| 100 μm | A1 | 25 | 0.76 | OC | 0 | 0.95 | 24 | 7.6 | 19 | 5 | 80 | 7.6 |
| Nafion ® | A2 | 50 | 0.68 | A1 | 25 | 0.76 | 48 | 5.4 | 34 | 14 | 72 | 3.2 |
| PEM | A3 | 115 | 0.60 | A2 | 50 | 0.68 | 109 | 3.0 | 69 | 40 | 63 | 1.2 |
| | A4 | 180 | 0.50 | A3 | 115 | 0.60 | 171 | 2.5 | 90 | 81 | 53 | 1.5 |
| | A5 | 200 | 0.45 | A4 | 180 | 0.50 | 190 | 2.5 | 90 | 100 | 47 | 2.5 |
| 20 μm | B2 | 50 | 0.83 | OC | 0 | 0.95 | 48 | 2.4 | 42 | 6 | 87 | 2.4 |
| PFSA-PTFE | B3 | 115 | 0.79 | B2 | 50 | 0.83 | 109 | 1.4 | 91 | 18 | 83 | 0.6 |
| CRM PEM | B4 | 180 | 0.67 | B3 | 115 | 0.79 | 171 | 1.6 | 121 | 50 | 71 | 1.8 |
| | B5 | 200 | 0.60 | B4 | 180 | 0.67 | 190 | 1.8 | 120 | 70 | 63 | 3.5 |
| 20 μm | C2 | 50 | 0.93 | OC | 0 | 0.95 | 48 | 0.4 | 47 | 1 | 98 | 0.4 |
| Porous | C3 | 115 | 0.90 | C2 | 50 | 0.93 | 109 | 0.4 | 104 | 6 | 95 | 0.5 |
| PEM | C4 | 180 | 0.76 | C3 | 115 | 0.90 | 171 | 1.1 | 137 | 34 | 80 | 2.2 |
| | C5 | 200 | 0.69 | C4 | 180 | 0.76 | 190 | 1.3 | 138 | 52 | 73 | 3.5 |

From the above table the superior performance of the fabricated 20 m porous PEM over the 20 μm PFSA-PVA-PTFE composite reinforced membrane CRM is confirmed. Both the porous PEM and the CRM significantly outperform conventional 100 μm Nafion® based membranes. All membranes employed a industry standard homogenous gas diffusion layer. A thorough comparison reveals several key beneficial innovations, namely
The porous membrane exhibits almost no activation losses, i.e. no significant voltage droop in the first 50 mA/cm². In contrast Nafion® exhibited a 30% drop of 0.27V from 0.95V to 12 0.68V over the same current range.
For a power input of 109 mW/cm², nominal operation in the ohmic region, the porous PEM maintained a high cell voltage of 0.9V delivering 104 mW/cm² output at a power conversion efficiency of 95% while the Nafion® film delivered only 69 mW/cm² at a poor efficiency of only 63%. The PFSA CRM membrane outperformed Nafion® at an efficiency of 83% with a delivered power of 91 mW/cm².
At a higher power input 171 mW/cm² in the higher end of the ohmic operating range, the porous membrane maintained an efficiency over 80% delivering 137 mW/cm² while Nafion® membrane falls to 53% power efficiency and only 90 mW/cm² producing almost as a much heat as delivered power. The developed PFSA-PTFE CRM maintained a usable 71% efficiency and 121 mW/cm² but not competitive to the porous PEM.
At high input power densities of 190 mW/cm² and over, all fuel cell exhibit efficiency loss due to carrier transport mechanisms and water logging. That said, the efficiency of the porous PEM maintained the best performance at 73% power efficiency, the CRM film delivered 63%, and the Nafion® film fell to 47%.
Beyond the activation operating region where resistance is not phenomenologically representative of fuel cell physics, the DC specific resistance the Nafion® membrane over 109 mW/cm² of input power ranged from 2.5-to-3.0 Ωcm² while the porous PEM exhibited specific resistances of 0.4-to-1.3 Ωcm², representing an 48% to 84% reduction. The CRM maintained a range of 1.4-to-1.8 μcm², a 40% improvement over conventional fuel cells.
Small signal DC impedance rₛₛ of the fabricated fuel cells ranged 0.6-to-3.5 Ωcm², slightly lower than Nafion® in the ohmic range but more resistive at high power densities.

FIG. 85D illustrates the power output of CRM 600b and porous PEM 600c membranes contrasted against a conventional Nafion® based fuel cell 600a graphically as a function of input power illustrating the electrical benefits of membranes fabricated in accordance with this invention.

Curves 600c, 600b, and 600a further illustrates the improvements in power efficiency q of the new membranes, where η=(V_{OC}—Vₓ)/(Iₓ) at any point (Iₓ, Vₓ) and where V_{OC}=0.94V. Clearly the porous PEM is capable of delivering significantly higher power outputs and efficiencies than present day fuel cells. The observed improvement in efficiency not only improves fuel cell performance and conserves fuel, it also reduces waste heat dissipated in the fuel cell stack.

FIG. 85E illustrates measured power loss in a fuel cell as a function of input power density for three different fuel cells, namely Nafion® PEM 602a, PFSA-PVA-PTFE composite reinforced membrane CRM 602b, and porous PEM 602c. As shown Nafion® 602a dissipates significantly more power than the CRM and porous PEM films made in accordance with this invention. Note that while the lower abscissa and left ordinate axis have units of power density in mW/cm², the upper abscissa and right ordinate axis have units of watts for a fuel cell with an active area of 120 cm², i.e. where the unit area A_{FC}=1 cm² and where m=120.

FIG. 85F illustrates the same data sets replotted as the power loss Pₗₒₛₛ, i.e. dissipated heat in the fuel cell, as a function of the delivered output power of the fuel cell P_{L} for Nafion® PEM 603a, PFSA-PVA-PTFE composite reinforced membrane CRM 603b, and porous PEM 603c. The left and bottom axis are plotted in units of power density in mW/cm² while the right and upper axis are labelled in units of watts for a fuel cell with an exemplary active area of 120 cm², i.e. where m=120. The unique data first-of-its-kind representation illustrates that at a certain power density specific to the onset of transport limited conduction losses increase rapidly. While for Nafion® PEM 603a this upturn occurs at 90 mW/cm², for CRM PEM 603b the onset of transport losses occurs at 120 mW/cm² while for porous PEM 603c the threshold improves to 140 mW/cm², a power density 50% greater than commercial films. Below the threshold, the porous PEM dissipates significantly less power for the power delivered than the Nafion® PEM.

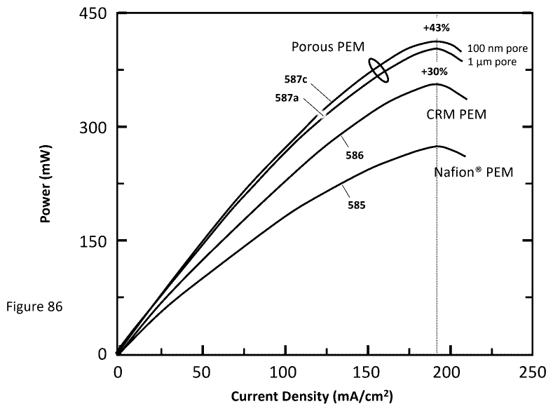

In general the lossy inflection point roughly corresponds to the current at which peak power delivery occurs. FIG. 86 illustrates power output as a function of PEM current density. The graph contrasts 100 μm Nafion® PEM 585 against a 20 μm CRM 586 and two different 20 μm porous PEMs—curve 587a describes a film with 1 μm pores while curve 587c is for membranes with 100 nm pores. As shown fabricated PEMs all show peaks at current densities around I_{FC}/A=180 mA/cm² with 20 μm CRM 586 exhibiting a peak power output +30% above Nafion®. As shown, 20 μm porous PEMs exhibit a power performance improvement of 43% above Nafion® with smaller pore films exhibiting a slight improvement in power density over the larger pore membrane.

There is no one-to-one correspondence between current density I_{FC}/A and power density P/A because the fuel cell voltage V_{FC} is itself a function of current. Using the above table however power and voltage do correlate for each particular film. Specifically at I_{FC}/A=180 mA/cm², a 100 am Nafion® PEM 585 exhibits a voltage of 0.5V and a power density at 90 mW/cm². At the same current, a 20-μm CRM PEM 586 exhibits a voltage of 0.67V and a power density at 121 mW/cm² while the fabricated 20-μm porous PEMs exhibit a voltage of approximately 0.76V with a corresponding power density at 137 mW/cm². The performance of a fuel cell is also however, influenced by the performance of the gas diffusion layers that transport gas to the membrane.

### Gas Diffusion Layer Fabrication.

The gas diffusion layer or “GDL” performs a number of roles in a PEM based fuel cell including providing (i) electric connection between the bipolar plate (BP) and catalyst layer (CL), (ii) pathways for reactant transport, heat and water removal, (iii) mechanical support for the membrane electrode assembly (MEA), and (iv) protection of the CL from erosion by gas flows or other factors. Physical processes in GDLs include diffusive transport, bypass flow induced by in-plane pressure differentials between neighboring channels, through-plane flow induced by mass sourcing and sinking to catalyst layers, heat transfer, two-phase flow, and electron conductance.

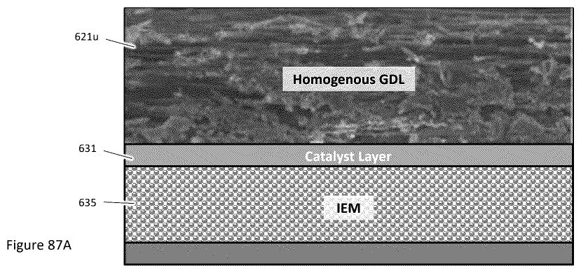

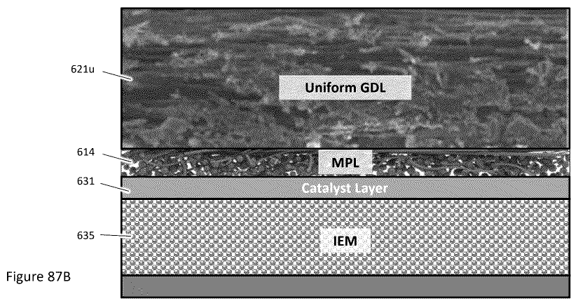

FIG. 87A illustrates a GDL comprising a GDL comprising a single layer of uniform, i.e. homogenous, material 621u contacting catalyst layer 631 in turn formed on ion exchange membrane IEM 635. Unfortunately, gas diffusion layers using a single homogenous layer of porous material suffer from numerous deficiencies fatal to PEM operation. If the porosity of a uniform GDL is too great a number of adverse effects degrade GDL performance. These adverse effects include a variety of mechanisms including (i) nominal gas pressure levels P_{gas} will cause excessive gas flow rates in the PEM, (ii) water will accumulate at the CL-GDL interface causing water logging, (iii) reduced contact area between the GDL and the catalyst layer results in high interfacial contact resistance with large ohmic membrane losses, and (iv) electrical performance is overly sensitive to applied pressure causing GDL deformation affecting gas conduction and film conductivity.

The problem with any uniform material used to form a gas dis diffusion layer is an intrinsic tradeoff between atoms carrying current and the pores in between carrying gasses. Increasing the pore size improves gas flow but increases electrical resistance. Conversely smaller pores increase GDL surface contact area lowering contact resistance and improving the atomic volume of electrical conducting atoms in the GDL matrix, together reducing series resistance through the layer. Unfortunately, smaller pores limit gas transport through the matrix reducing the hydrogen fuel supply arriving at the PEM interface available to sustain necessary redox reactions. Smaller pores also adversely impact the cathode GDL's ability to remove generated water from the cell. Accordingly, a gas diffusion layer of unform porosity represents a significant compromise between gas and water transport versus electrical and thermal conduction. The resulting tradeoff results in IEMs with high electrical resistance, a propensity for water logging and membrane swelling, low cell voltages, and increased sensitivity of fuel cell performance to atmospheric humidity.

In an attempt to ameliorate this issue, commercial GDLs today generally comprise two layers as shown in FIG. 87B—a thicker uniform macroporous GDL 621u, and a thinner microporous layer or “MPL” 614 used for interracially managing charge and material transport. The introduction of thin MPL 614 between the gas diffusion layer 621u and the catalyst layer 631 allows for independent control of contact resistance and gas diffusion. Specifically the smaller pore material contacts the catalyst layer to reduce electrical contact resistance to the electrically active catalyst layer while the second thicker GDL layer comprises a sparser atomic matrix contacting the bipolar plate. Because of the preponderance of conductive carbon in both layers, there is essentially no contact potential or interfacial resistance between GDL 621u and MPL 614.

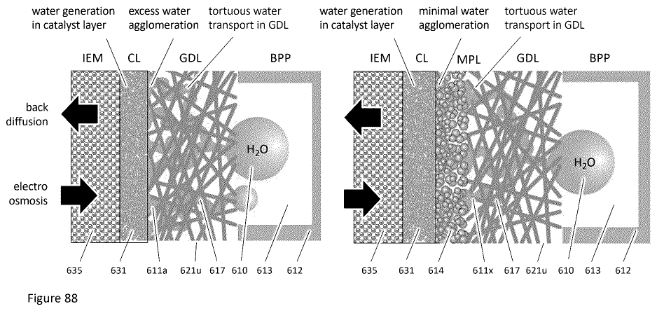

One immediate benefit of the bilayer GDL is the control of water agglomeration at the interface between the cathode catalyst layer 631 and the gas diffusion layer. Referring to FIG. 88, water transport mechanisms in a hydrogen fuel cell include water generation and condensation within catalyst layer 631 complicated by water transport within IEM membrane 635 involving electroosmosis countered by back diffusion. These competing electrochemical and physical mechanisms are responsible for the complex electrical conductance characteristics of a fuel cell as a function of current density.

As shown in schematic on the left, in the absence of an microporous layer water transport from the CCM-GDL interface through GDL 621u to the gas channel “cathode chamber” 613 in cathode bipolar plate BPP 612 involves a convoluted interstitial path 617 referred to as tortuous water transport. Without controlling water diffusion, generated condensed water 610 also agglomerates 611a along the CCM impeding conduction and fuel cell operation. By introducing MPL 614, the water generation rate is controlled by MPL porosity greatly reducing water agglomeration 611x and reducing the propensity for membrane swelling and water logging.

It should be mentioned, that some publications refer to a macroporous substrate or MPS. This term is less common and somewhat confusing as it presumes a specific fabrication flow, specifically as the term “macroporous substrate” implies the GDL starting material contain larger pores than other layers within the gas diffusion layer. Care must be taken when examining publications to clarify the lexicology of the specific journal.

Practically speaking the starting substrate such as carbon paper may comprise larger pores than subsequent layers deposited on it or vice versa just so long that the smaller pore material contacts the CCM and the larger pore side contacts the bipolar plate. In essence the sequence by which the bilayer material is formed is irrelevant so long that it is assembled into MEA5 in the proper orientation. Within this application the term microporous layer (MPL) shall mean GDL layer having smaller pore sizes than other layers in the GDL, irrespective as to whether the MPL was used as a substrate in fabrication, or if it was deposited on another layer.

Although a bilayer GDL affords added control in balancing water and electric conduction, homogenous gas diffusion layers are far from optimum. In a creative embodiment of this invention, gas diffusion layers made in accordance with this invention comprise a deposited carbon layer that is neither homogenous in chemical composition and stoichiometry, nor uniform in porosity. The term hGDL is used herein to describe multilayer ‘heterogenous gas diffusion layers' structures and to differentiate them from conventional bilayer GDLs having a single uniform deposited layer.

Fabrication of these next generation GDLs may involve a variety of materials including carbon paper, carbon fiber, carbon cloth, or carbon felt. Carbon is attractive because of its good thermal and electrical conductivity, its permeability to gasses, its low chemical reactivity and immunity to oxidative degradation, and lack of toxicity. Importantly carbon is hydrophobic helping drain condensed water and preventing undesirable edema-like water retention and membrane swelling. Alternative GDL materials may include metal based meshes and porous films but these materials suffer corrosion risks and are generally too hydrophilic for good water clearance.

Although carbon fiber paper offers superior electrical performance, carbon fiber cloth more easily stretches and deforms to better match the topography of the CCM catalyst layer and the bipolar plate sandwiching the GDL. The rigidity of carbon cloth can be modified and conductivity enhanced by applying additives such as carbon black powder or phenolic resin followed by a high temperature carbonization process. Alternative GDL materials include a polyacrylonitrile (PAN) derived carbon cloth, cellulose, or cotton fibers chemically coated to enhance their conductivity. One material well suited for realizing a porous structure with electrical conductivity is carbon in the form of graphite. Other candidates include carbon fibers, carbon nanotubes, graphene, and various composite materials.

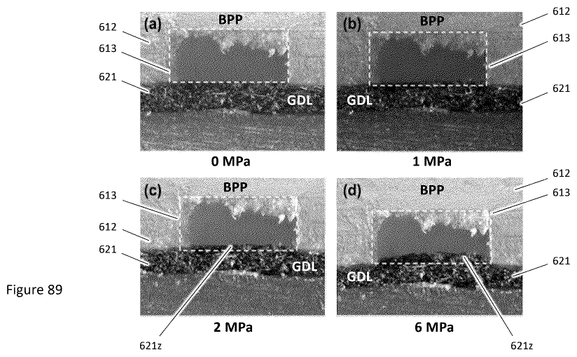

Another concern is the behavior of a GDL under mechanical pressure. In fuel cell assembly the stack of membranes is compressed to ensure good contact between the conductive elements within the cell. Unfortunately, a sparse carbon matrix is compressible and will deform, allowing the GDL to encroach into the gas channels of the BPP and impeding gas flows. As shown in FIG. 89, applying a fuel cell structure comprising GDL 621, BPP 612, and gas channel 613 shows no deformation or MPL encroachment at a pressure up to 1 megapascal with units MPa. At 2 MPa some deformation 621z encroaches into gas channel 613. At 6 6 MPa however a significant volume of GDL 621z invades the gas channel affecting hydrodynamic flow. The over-compression problem can made in accordance with this invention be reduced by lowering the applied torque on the assembly screws to 3 MPa or by fortifying the GDL mechanically with carbon nanotubes or with polymers such as plastics or PTFE fillers up to 10% by weight.

Although GDLs can be formed by manually spraying or painting layers onto carbon paper, these methods are not reproducible, manufacturable, or scalable, as pore size depends on deposition rate, processing temperature, and stoichiometric solute concentration. Another challenge to reproducibility is the need to constantly stir carbon paints to maintain mixing and prevent fibers from precipitating out of solution.

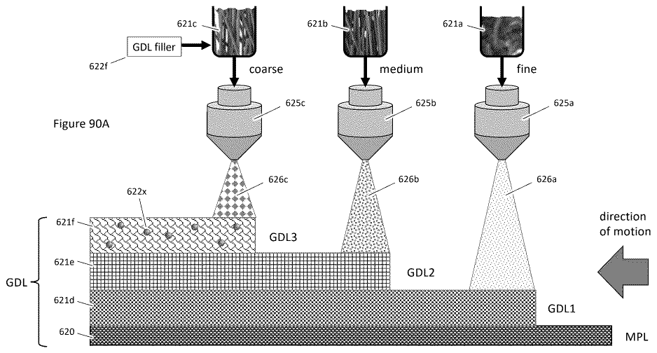

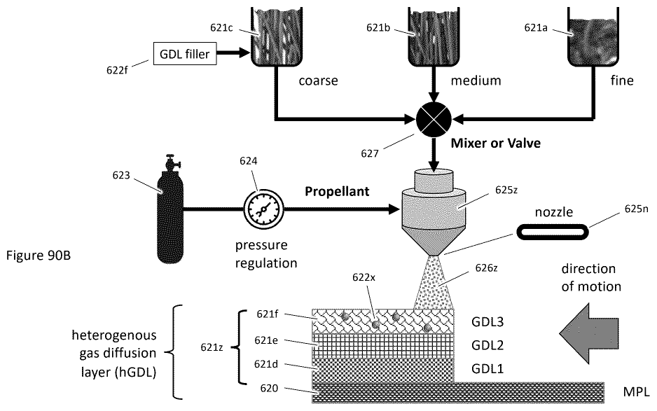

As disclosed herein, one embodiment of this invention able to precisely control film thickness, stoichiometry and porosity of a multilayer carbon film involves the sequential deposition using a multi-head printer depicted schematically in FIG. 90A. In the fabrication sequence shown carbon is deposited onto a starting substrate comprising a premade microporous layer. During processing three sources of carbon 621a, 621b, and 621c offering different degrees of granularity, namely fine, medium, and coarse fibers respectively, are sequentially deposited through separate print heads 625a, 625b, and 625c onto MPL carbon paper 200 as a starting substrate.

The term MPL is referred to as a “micro-porous layer” indicating the size of the pores in the paper are smaller than one micron, typically 0.5-to-1.0 μm in diameter, smaller than the carbon deposited onto it. In 2D printing the print head must scan back and forth as the carbon MPL paper is fed through the printer in the same manner an inkjet printer works. Alternatively, the print head may comprise a continuous bar or a number of smaller print heads able to uniformly print the entire width of the paper in one pass eliminating the need for scanning the a single print head back and forth across the paper width.

In the case of linear motion of the carbon paper illustrated in FIG. 90A, the uncoated carbon paper 620 is first coated by spray 626a with the material 621a to produce a deposited layer 621d comprising the least porous layer GDL1. As the paper advances areas already coated by GDL1 are next coated by spray 626b with the material 621b to produce a deposited layer 621e comprising the layer GDL2 of medium porosity. As the paper further advances, areas already coated by GDL2 are next coated by spray 626c with material 621c to producing deposited layer 621f comprising the porous layer GDL3. This final deposited layer 621f, the most coarse and porous of the three, may also be doped with scavenger molecules comprising GDL filler 622f introduced into the ink slurry shown as material 621c.

In one embodiment, the addition of GDL filler 622f during deposition results in permanent fillers 622x being formed with the printed GDL matrix. The function of the GDL filler is to sequester and degrade carbon monoxide (CO) to protect the CCM catalyst layer such as platinum from poisoning. Mechanistically carbon monoxide scavengers useful as GDL fillers made in accordance with this invention include elements able to oxidize CO into CO₂. These include metal oxides of cerium oxide (CeO₂), iron oxide (Fe₂O₃), manganese oxides such as MnO, calcium titanium oxides including CaTiO₃ aka perovskite oxides, and copper based catalysts such as CuO. Aside from oxides of transition metals (TMs), other physical structures containing TMs may include functionalized carbon nanotubes, metal organic frameworks (MOFs), functionalized graphene substrates, TM nanoclusters, and functionalized polyhedral silsesquioxanes such as POSS and DDSQs. Other catalysts able to oxidize CO when embedded into the carbon matrix of the GDL include gold (Au) nanoparticles, bimetallic compounds such as platinum-tin (Pt—Sn), zeolites, and catalysts of rhodium (Rh) and ruthenium (Ru) in various elemental, compound, and MOF configurations. For example, in ruthenium catalyzed reaction of carbon monoxide to form carbon dioxide, the reaction is given by CO+Ru+½/(O₂)→CO₂+Ru where the ruthenium is recovered fully with each turn. While the turnover frequency (TOF) for ruthenium (Ru) catalysts in the oxidation of CO to CO₂ varies by temperature and pressure, in general a TOF of several hundred conversions per second is possible.

Like MOFs, zeolites can be used to complex catalytic transition metals such copper (Cu), iron (Fe), or cobalt (Co) into high temperature catalysts. Zeolites, aluminosilicates with a crystalline structure composed of SiO₄ and AlO₄ tetrahedra linked by shared oxygen atoms offer a variety of advantages to enhance TM performance and longevity in catalysis. Specifically, introducing a transition metal into zeolite allows the metal atom to function as the active reaction site while the inert zeolite framework provide chemical and thermal stability. Moreover, the porous structure of zeolites provides a large surface area, enhancing the adsorption of CO and facilitating the contact between reactants and catalytic sites. Examples of zeolite CO scavengers compatible with used in the inventive include copper zeolite (Cu-ZSM-5) and cobalt zeolite (Co-ZSM-5) where either copper or cobalt have been substituted into the zeolite atomic framework.

Using any of the scavengers described above, the GDL fillers behave like a microscopic scrubber similar to a catalytic converter in automotive vehicles but on a molecular scale. Although these scavengers may be introduced anywhere within the GDL or MPL substrate, they may also be contained in specific portions of the deposited film to reduce material costs. For example, the permanent filler 622x may be isolated or concentrated within the more coarse GDL3 layer 621f where exposure to incoming airflow is statistically greater than in less porous regions of the carbon matrix such as layer GDL1.

In another embodiment of this invention, the required mol fraction of filler molecules should scale with the density of the carbon layer containing it. For example, the required density of filler 626x in coarse layer GDL3 621f is lower than that needed in the denser less porous first layer GDL1 621d. By this argument, the filler concentration in MPL 620 should be even higher commensurate to its higher density, which is a disadvantage in having a higher material cost. One advantage of doping the MPL substrate with the scavenger catalyst filler is that the carbon paper can be prefabricated with the catalyst already embedded, thereby eliminated the need to complicate the deposition process by including GDL filler 622f as a solute into the carbon ink material 621c.

Other non-obvious considerations in the hGDL process involve equilibrating deposition rates to achieve a steady membrane speed during printing especially in continuous print roll-to-roll processes. Since the carbon paper necessarily advances at a steady pace, producing each deposited layer to a specific thickness must account for differences in the formulations of carbon solutions 625a, 625b, and 625c, each with different viscosities and carbon filler sizes. To maintain a constant deposition rate despite varying viscosities, the fluid pressure must be maintained separately for all three nozzles 625a, 625b, and 625c.

Another variable to be considered is the distance between the print head nozzle and the paper. As more layers are deposited not only does the GDL thickness increase but the gap between the print head and the paper decreases meaning the spot width from spray 626c is smaller than 626a. To maintain a uniform thickness the pressure and flow rate driving the printer head 625c must be greater than head 625b which must be higher than the pressure driving 626a in order to produce similar thickness assuming comparable viscosities. In this manner, carbon growth can be adjusted dynamically producing a pore size increasing from layer GD1 to GDL2 to GDL3. Although the multiple head implementation can produce step changes in porosity the method cannot produce a smooth continuous gradation in pore size.

In another embodiment, to produce a continuum in pore size made in accordance with this invention requires blending, i.e. mixing 627 different carbon sources and spray them through a common spray nozzle. This sequential blended carbon coating method is shown in FIG. 90B where one print head 625z deposits some blend 626z of fine, medium, and coarse carbon coatings onto MPL carbon paper 620. In this process the print head remains above stationary position along the carbon paper until the full thickness of the GDL 621s is deposited. The layer may comprise discrete boundaries of compositions 621d, 621e, and 621f or may be continuously graded with no clear boundaries except between the deposited layer 621z and the MPL carbon paper 620. Precise deposition rates relies in pressure control 624 of propellant 623. In another embodiment of the invention, the print head nozzle opening 625n comprises a rounded rectangular shape able to facilitate printing of carbon links with longer fibers without clogging. The semi method may also be applied to multi-head carbon printing where the length of the orifice is greater for the longer carbon fiber solutes and smaller for the fine textured printing.

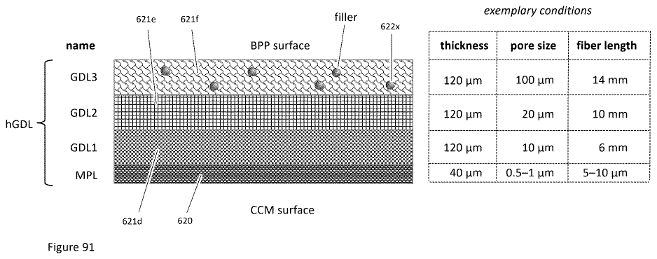

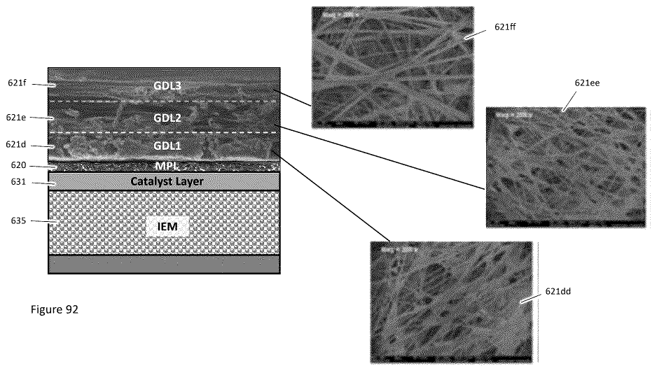

As depicted in schematic cross section of FIG. 91, the size of the pores are graded from micron sizes at the GDL-to-CCM interface to macropores located at the top of the GDL adjacent to the bipolar layer and gas channels. The submicron pore size of the micropore layer 620 or MPL at the CCM interface maximizes contact area. Atop the MPL is a graded gas diffusion layer of varying pore sizes, For example the carbon paper may comprise a micropore layer 40 μm thick with pore sizes of 0.5 μm to 1.0 μm. The surface area available for ohmic contact to the CCM is approximately 3 50%. Formed atop the MPL is the GDL1 of 120 μm thickness containing 10 μm pores followed by GDL2 comprising a 120 μm thick layer of 20 μm pores, covered by GDL3 comprising a 120 μm layer with 100 μm sized pores. Overall the GDL thickness usually ranges from 100-to-500 μm. SEM photographs of fabricated films are included in FIG. 92 including GDL1 shown in SEM 621dd, GDL2 shown in SEM 621ee, and GDL3 shown in SEM 621ff.

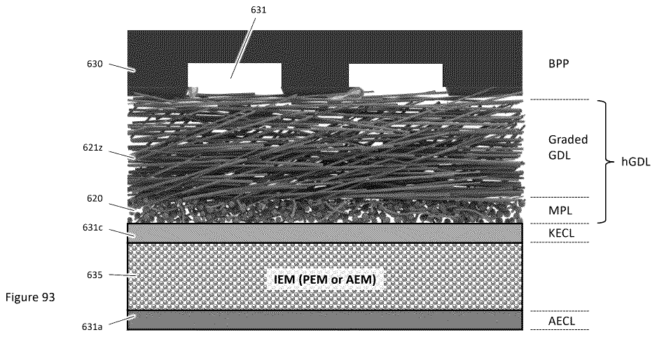

Alternatively the pore size gradation can be more gradual as represented by graded GDL layer 621z shown in FIG. 93. The actual pore dimensions may vary depending on the process but in general the advanced hGDL gas diffusion layer made in accordance with this invention comprises a monotonic increase in density from its MPL base 620 abutting the CCM core to the top of the composite GDL layers abutting bipolar or tripolar plate. Specifically as shown in the illustration MPL layer 620 contacts cathode catalyst layer 631c present on the top of ion exchange membrane 635. The more porous top of composite GDL layers 621z abut bipolar plate 630 and gas channel 631. In one embodiment, the gradation in porosity of the GDL varies monotonically from the dense MPL 620 adjacent to the CCM to a lower fiber density adjacent to the bipolar plate 630.

While the exemplary cross section depicts the GDL attached onto the anode side of the CCM, i.e. where MPL 620 contacts cathode catalyst layer 631a, a second GDL of similar but not necessarily identical construction is attached on the anode side of the GDL contacting anode catalyst layer 631a. Although the same gas diffusion layer material may be used for both cathode and anode, the construction of the films as disclosed may also differ between the anode and cathode to better match the transported charge and electrochemistry of the redox half cell and whether the reaction at the interface involves oxidation or reduction chemistry.

The resulting gradient in gas concentrations from varying the film pore size improves gas transport by introducing diffusion assisted transport offsetting some of the impact of the micropore interface. A four zone graded GDL structure although not continuous to be vastly superior to the unform of uniform GDL atop the MPL demonstrated thus far. Five zone, six zone, or continuously graded pores are expected to further enhance fuel cell function and durability.

Pore size can varied by charging the growth conditions and by changing the length of carbon fibers used in the film growth. In one embodiment the micropore layer is composed of fibers 5-to-10 μms in size while the three GDL layers range from 6 mm up to 14 mm. During deposition, the average length can be adjusted by controlling the blend of mix of the carbon fibers in a continuous process. For example 6 mm fibers are transitioned to 10 mm fibers by decreasing the flow rate of the shorter fiber and gradually increasing the longer fiber content to replace shorter elements.

In one embodiment of this invention, the average porosity of the GDL on the cathode and anode side of the fuel cell need not be the same. For example, in a hydrogen fuel cell the anode involves ionized hydrogen (proton) transport while in the cathode the reducing agent is either pure gaseous oxygen or filtered air comprising a mix of 78% nitrogen and 21% oxygen not including water vapor which is present in both the FC's anode and cathode. Since the oxygen molecule O₂ is larger than hydrogen molecule H₂ and the proton H⁺, on one embodiment of this invention the GDL average porosity on the cathode carrying oxygen is fabricated with larger pores than the GDL used on the cathode.

Another important embodiment of the gas diffusion layer is to manage moisture in the cell during operation by draining away excess water, especially in the cathode. Water management includes process control of GDL porosity, tortuosity, and pore-size distribution (PSD). Made in accordance with the invention, moisture regulation is primarily controlled by hydrophobicity of the MPL layer and its interface to the catalyst layer, balancing the competing processes of membrane drying and water flooding.

The material properties may be adjusted by infiltrating using carbon nanotubes into the MPL, introducing NH₄Cl ammonium chloride followed by recrystallization and pyrolysis, adding graphite powder or alternatively blending a small concentration of hydrophobic PTFE, e.g. 10% by weight into the carbon matrix. Alternatively graphene oxide may be employed when fabricating gas diffusion layers where the crystallinity of a carbon matrix is used to adjust its tensile strength and electrical conductivity based on the mix of C═O and C—O covalent bonds formed between the GO and the carbon fiber. Likewise permanent fillers designed to degrade atmospheric toxins such as CO into nonreactive CO₂ may be included in the cathode GDL for a hydrogen fuel cell but are not required on the anode.

Note that the term “gas diffusion layer” is borrowed from the lexicography of hydrogen fuel cells where the reactants including the charge source such as ionized protons and the reducing agents such as oxygen are gaseous. In the case of glucose and hydroxide fuel cells however, charge conduction does not involve a gas but a suspension of cations or anions in solution.

In an exemplary fabrication sequence as described the GDL is formed on a carbon paper substrate then attached to the catalyst layer of the MEA3 core of the fuel cell. The assembly based process for attaching the GDL to the CCM is discussed later in a related application related application titled “Advanced Fuel Cell—Design, Apparatus, & Fabrication,” referenced herein. The specific sequence, whether connecting the CCM to the anode side or cathode side GDL is not critical nor is the exemplary sequence intended to be limiting. Although the same GDL can be used for both anode and cathode sides of the CCM, in general the gases on the cathode side namely O₂ and H₂O are atomically larger than the H₂ gas feeding than anode. As such, in one embodiment the pore sizes of the cathode size GDL are larger than that on the anode.

In one embodiment of this invention, the GDL attached to the cathode side of the CCM membrane in an MEAS assembly may include additives such as metal oxides, metal functionalized carbon nanotube, boron nitride nanoparticles, bismuth compounds, and polyhedral silsesquioxanes such as POSS and DDSQs, able to disrupt diffusion of atmospheric contaminants such as nitric oxide (NO) from reaching the CCM from ambient air supplies and poisoning the catalyst, the ionomeric groups, or both. In other words, scavengers preventing damage to the cathode catalyst layer (CCL) need not be limited to the catalyst layer itself but may be integrated into the gas diffusion layer, removing toxins before ever reaching the catalyst layer.

In another embodiment, a direct methanol fuel cell (DMFC) comprises a heterogenous gas diffusion layer (hGDL) containing permanent GDL fillers embedded within the carbon matrix to remove contaminants present in the methanol before they can reach or damage the CCM. Methanol contaminants may include sulfur compounds, chlorides, and carbon monoxide (CO) all of which can adsorb on platinum, blocking active sites, and degrading catalyst activity in the anode ACL. Permanent fillers added into the anode GDL for DMFC include ruthenium or osmium additives and other transition metals used to break apart contaminants, cerium oxide (CeO₂) acting as a store of oxygen able to oxidize CO₂ and other compounds, and manganese Oxide (MnO₂) useful in capturing sulfur compounds. These permanent GDL fillers help protect the anode's platinum catalyst in a DMFC by either reacting with the contaminants or by providing alternative pathways for oxidation

In another embodiment of this invention, the MPL side of the GDL can also be coated with an interfacial layer containing a stoichiometric blend of the atomic composition of the GDL and the catalyst layer. The benefit of coating the CCM facing side, i.e. the MPL of the GDL, with an interfacial deposition is to reduce to interfacial states between the GDL and the CCM and in so doing reducing the contact resistance and improving overall fuel cell efficiency. For example, this interfacial layer between the GDL and CCM may comprising a blend of inert PTFE nanoparticles, palladium metal, titanium dioxides, carbon, carbon fibers, graphene, and scavenger metals such as tungsten, nickel, and other transition metals less sensitive to corrosion.

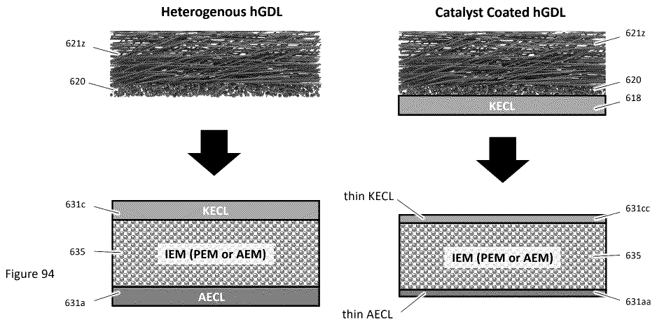

In an alternative process the thickness of the catalyst layers formed on the ion exchange membrane can be thinned and a second catalyst layer formed on the underside of the GDL. This process, depicted in FIG. 94 is contrasted against a conventional CCM assembly. Specifically in the case of a uncoated hGDL gas diffusion layer comprising graded GDL 621z and MPL 620, the GDL is attached directly onto cathode catalyst KECL 631c. Because they are of dissimilar materials some contact resistance invariably occurs between the two GDL and the CCM. In the case of a catalyst coated GDL shown on the right, a hGDL comprising graded GDL 621z and MPL 620 is coated with catalyst layer 618.

The catalyst layer can be applied onto the MPL using a decal laminate, attached then annealed to minimize contact resistance. Fabrication of the CCM comprising IEM 635 and catalyst layers 631aa and 631cc can be made using a thinner catalyst layer. If these catalyst layers are sputtered onto IEM 635 all surface states can be eliminated. Beneficially in accordance with this invention, when attaching KECL 618 of the catalyst coated GDL to thin catalyst 631cc, the two materials are similar or identical thereby avoiding all contact resistance between the two elements. In this manner the total interfacial resistance between the hGDL, catalyst layer, and IEM are minimized.

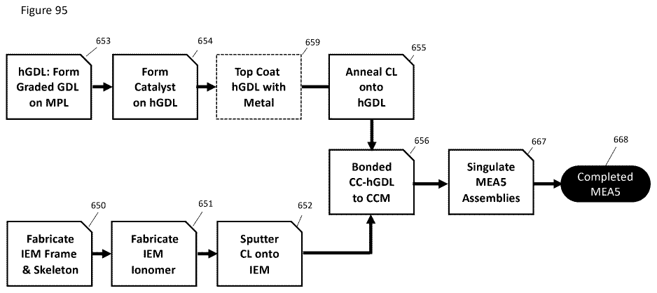

FIG. 95 illustrates the process flow for fabricating a MEA5 using a catalyst coated heterogenous gas diffusion layer or CC-hGDL. Made in accordance with the previously defined process, in step 650 a frame and skeleton are first molded followed my ionomer fabrication 651 and sputter etch and catalyst depositions 652. In a parallel path fabrication of a heterogeneous gas diffusion layer starts with printing or coating a graded GDL onto a MPL 653, then printing, depositing, or laminating the GDL with a catalyst layer 654 followed by thermal annealing 655 to produce a CL-hGDL. The CCM and CL-hGDL are then bonded 656, annealed, and singulated 667 to complete fabricated MEA6 668.

In an alternative embodiment the top of the GDL can be coated with a conductive complex such as copper-carbon (Cu—C) to improve the electrical contact with the bipolar plate. Referring again to the flow chart if FIG. 95, step 659 is optionally included to reduce interfacial contact resistance. The key components of the film ideally will include carbon, copper, and any other metal that might be present in the bipolar plate. The thickness need only be 10 μm in order to reduce contact resistance.

### PEM+ Electrical Characteristics.

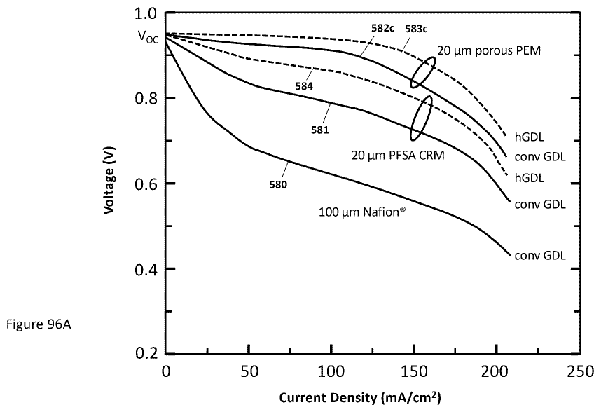

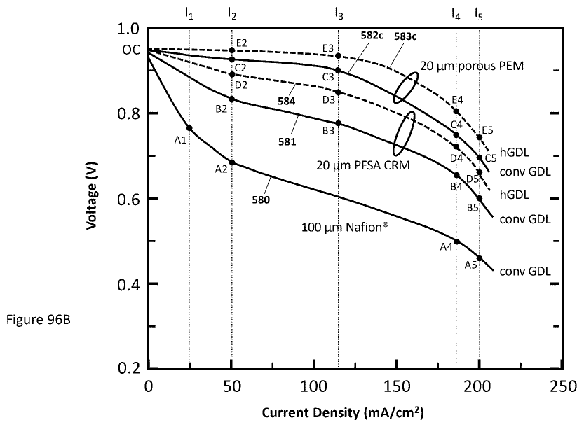

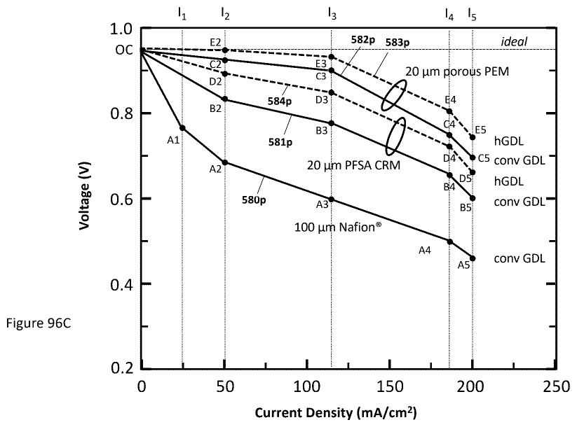

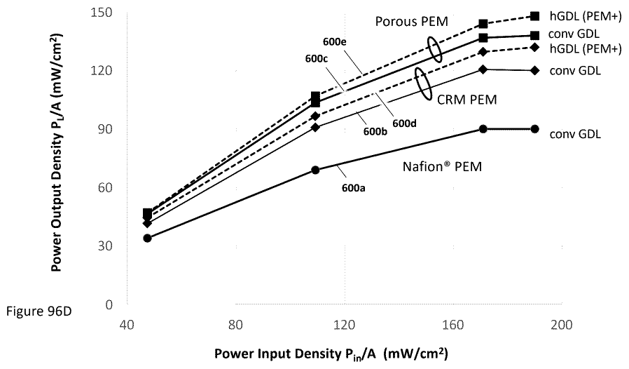

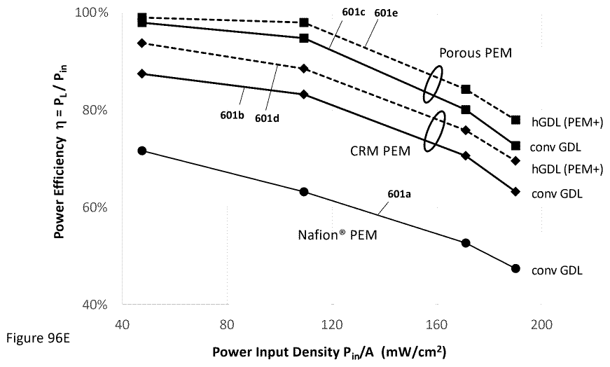

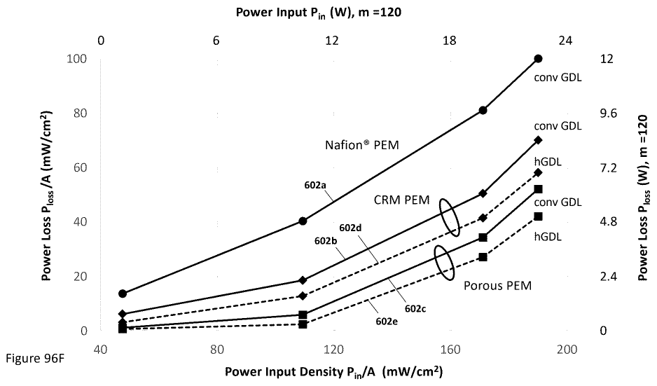

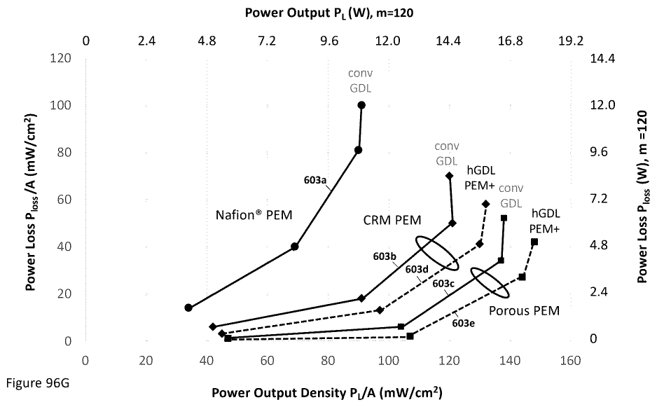

To isolate the impact of a graded hGDL heterogenous gas diffusion layer on PEM electrical performance, various structures were fabricated, combined with various membranes, and characterized. FIG. 96A illustrates the voltage current characteristics, i.e. the polarization curves of a 100 μm Nafion© film 580 against four different advanced fuel cells made in accordance with this invention—two using a standard bilayer GDL and two using the inventive heterogenous hGDL.

As shown, all four improved membranes 581, 582c, 583c and 584 significantly outperformed Nafion® film 580 exhibiting reduced polarization losses, lower resistance, and lower voltage droop. As measured a 20 μm CRM composite reinforced membrane 584 using an innovative PFSA-PVA-PTFE film combined with the hGDL heterogenous gas diffusion layer outperformed the same membrane using a conventional bilayer GDL 581. Similarly the 20 μm porous PEM combined with the hGDL heterogenous gas diffusion layer 583c outperformed the same membrane using a conventional bilayer GDL 582c. In other words, the graded hGDL made in accordance with this invention has been experimentally confirmed to outperform the same CCM using conventional GDLs.

FIG. 96B compares measured fuel cell polarization curves of conventional GDL and graded hGDL refenced against currents I₁/A_{FC}=25 mA/cm²; I₂/A_{FC}=50 mA/cm²; I₃/A_{FC}=115 mA/cm²; I₄/A_{FC}=185 mA/cm²; and I₅/A_{FC}=200 mA/cm². Curve 580, the polarization curve for a 100-μm Nafion® membrane includes data points A1 through A5 with numerically corresponding to the current subscripts.

Curves 581 and 584 with data points B2-B5 and D2-D5 illustrate polarization curves for 20-μm PFSA CRM membrane contrasting conventional GDLs and heterogeneous hGDL. Curves 582c and 583c with data points C2-C5 and E2-E5 illustrate polarization curves for 20-μm porous PEM membrane contrasting conventional GDLs and heterogeneous hGDL. The hGDL data are summarized in the table below describing the measured voltage Vₓ and Vₓ₋₁ at two adjacent points, the power input Pᵢₙ, power output P_{L}, and power loss Pₗₒₛₛ along with the efficiency η_{FC}, the DC resistance R_{FC} and the differential resistance rₛₛ.

| | X | Iₓ/A | Vₓ | X − 1 | Iₓ₋₁/A | Vₓ₋₁ | Pᵢₙ/A | R_{FC} | P_{L}/A | Pₗₒₛₛ/A | η | rₛₛ |
|---|---|---|---|---|---|---|---|---|---|---|---|---|
| | Units | | | | | | | | | | | |
| Membrane | — | mA/cm² | V | — | mA/cm² | V | mW/cm² | Ωcm² | mW/cm² | mW/cm² | % | Ωcm² |
| 20 μm | D2 | 50 | 0.89 | OC | 0 | 0.95 | 48 | 1.2 | 45 | 3 | 94 | 1.2 |
| PFSA-PTFE | D3 | 115 | 0.84 | D2 | 50 | 0.89 | 109 | 1.0 | 97 | 13 | 88 | 0.8 |
| CRM + hGDL | D4 | 180 | 0.72 | D3 | 115 | 0.84 | 171 | 1.3 | 130 | 41 | 76 | 1.8 |
| PEM+ | D5 | 200 | 0.66 | D4 | 180 | 0.72 | 190 | 1.5 | 132 | 58 | 69 | 3.0 |
| 20 μm | E2 | 50 | 0.94 | OC | 0 | 0.95 | 48 | 0.2 | 47 | 1 | 99 | 0.2 |
| Porous | E3 | 115 | 0.93 | E2 | 50 | 0.94 | 109 | 0.2 | 107 | 2 | 98 | 0.2 |
| hGDL | E4 | 180 | 0.80 | E3 | 115 | 0.93 | 171 | 0.8 | 144 | 27 | 84 | 2.0 |
| PEM+ | E5 | 200 | 0.74 | E4 | 180 | 0.80 | 190 | 1.1 | 148 | 42 | 78 | 3.0 |

From the tabulated polarization curve data, a direct comparison between the heterogenous GDL and a conventional GDL can be made. For example hGDL point D3 has a voltage V_{FC}=0.84V with a corresponding efficiency η_{FC}=V_{FC}/V_{OC}=0.84V/0.94V=89%. By contrast point B3 for a 20-μm PFSA CRM membrane described in a previous table, has a voltage V_{FC}=0.79V with a corresponding efficiency η_{FC}=V_{FC}/V_{OC}=0.79V/0.94V=84%, five points lower than the hGDL fuel cell.

Similarly hGDL point E3 has a voltage V_{FC}=0.93V with a corresponding efficiency η_{FC}=18 V_{FC}/V_{OC}=0.93V/0.94V=99% while point C3, the polarization curve for a 20-μm PEM CRM membrane at the same current density has a voltage V_{FC}=0.90V with a corresponding efficiency η_{FC}=V_{FC}/V_{OC}=0.90V/0.94V=96%, three points lower than the hGDL fuel cell. The combination of the advanced membrane fabrication technologies together with heterogenous gas diffusion layer for convenience sake are referred to herein as PEM+ membrane.

In order to extract component resistances, FIG. 96C illustrates measured polarization curves converted into piecewise linear segments having differential resistances rₛₛ approximated by each segment's two end points and a DC resistance R_{FC}=Vₓ/Iₓ determined by the curve's endpoint) Iₓ, Vₓ). These piecewise linearized representations include 100-μm Nafion® curve 580p, the 20-μm PFSA CRM PEM+ curves 581p and 584p, and the 20-μm porous PEM+ curves 582p and 583p.

From the foregoing measurements, the fabricated 20-μm CRM composite reinforced membrane comprising a PFSA-PVA-PTFE ionomer when combined with the graded hGDL heterogenous gas diffusion layer into a MEA5 showed an increase in power output and a reduction in membrane resistance compared to that of the same PEM membrane using a conventional bilayer GDL. Specifically, the conventional GDL MEA5 shown by curve 581p described in a previously reported table exhibited specific DC resistances R_{FC} ranging from 2.4-to-1.4 Ωcm² while the PEM+ version of the same membrane shown by curve 584p exhibited DC R_{FC} values of 1.5-to-1.0 Ωcm². Small signal resistances were non-monotonic, and similar to one another across the ohmic region of operation.

At every current density, the MEA5 based on the PEM+ membrane outperforms the conventional GDL. Small signal impedances of the CRM based PEM+ were slightly better than the conventional GDL device, in some cases being half the resistance but in other condition conditions being only comparable. The primary difference in these curves occurs at low currents corresponding to differences in activation energy. Small signal resistances in the ohmic region were more comparable.

Improvements demonstrated by curve 583p for the porous PEM+ membrane curves 585p are more substantial, varying from an extremely low 0.2 μcm² at low currents to only 1.1 μcm² at mA/cm² current densities. In contrast the porous membrane with a conventional GDL shown by curve 582p exhibits 0.4 μcm² at lower currents, double the resistance of its PEM+ counterpart, and exhibited 1.3 μcm² at 200 mA/cm² current densities, a 20% higher resistance than PEM+. Small signal impedance were also halved at low currents using the PEM+ MEA5 construction.

The reduced losses of the PEM+ MEA5 made in accordance with invention translates directly into an increase in delivered power for a specific input power, an increase in fuel cell power efficiency, and a reduction in waste heat generation. FIG. 96D illustrates a comparison of PEM and PEM+ based MEA5s. As shown, by combining a 20-μm porous ionomer with a heterogenous GDL the power output of PEM+ assembly 600e outperforms all other devices delivering nearly 150 mW/cm² from a 190 mW/cm² electrochemical input. In rank order of power output, porous PEM+ 600e delivers more power output than its conventional GD counterpart 660c. Combining PFSA-PVA-PTFE CRM with the disclosed hGDL, the power output of CRM-based PEM+ assembly 600d exceeds the output of comparable CRM-based PEM 600b but does not exceed the performance of either porous PEM implementation. The 100-μm Nafion© PEM underperforms all the other combinations.

Power efficiency η, the ratio of power output over power input is shown for various MEA5 assemblies in FIG. 96E. Of the combinations shown, 100-μm Nafion® PEM 601a exhibits the lowest efficiency with only 47%. In contrast the fabricated 20-μm CRM PEM efficiency using a conventional GDL 601b are at 63% and for a graded GDL 601d are at 69%. At 73% efficiency for a conventional GDL and at 78% efficiency using a hGDL, the performance of the porous PEM constructions outperform all other combinations. This benefits translates into lower fuel usage impacting driving range or power backup time, and less waste heat generation impacting fuel cell and system design factors.

In FIG. 96F, a graph of power loss illustrates that in order of unwanted heat dissipation 100-μm Nafion® PEM 602a is the worst dissipating 100 mW/cm² at a current density of 200 mA/cm² while porous PEM and PEM+ membranes shown by curves 602c and 602e dissipate the least heat at 52 mW/cm² and 42 mW/cm² respectively representing a 48%-to-58% reduction is generated waste heat. PFSA-PVA-PTFE composite reinforced membranes (CRM) offer intermediate improvements at 200 mA/cm² with power dissipation densities of 70 mW/cm² for a conventional GDL and 58 mW/cm² for a hGDL.

In real world applications, at 200 mA/cm² a m=120 fuel cell delivers 24A. At this current, the power loss in 120 cm² fuel cell depends on the technology employed. For example curve 602a for a 100 μm Nafion® membrane with a conventional bilayer GDL dissipates 12 W of power as heat, a PEM+ membrane and hGDL assembly shown by curves 602e dissipates only Pₗₒₛₛ=(42 mW/cm²)(120 cm²)=5 W in total representing a 60% overall reduction in heat generation. All intermediate implementations including those shown by the power dissipation curves 602b, 602d, and 602c are bounded by the two extremes.

Identical to the graph of FIG. 85F but for the hGDL devices, the transfer characteristics of power output as a function of electrochemical power input for a fuel cell are shown in FIG. 96G. The graph comprises power loss as a function of power output for a variety of PEM and PEM+ based fuel cells including Nafion® PEM-based MEA5 employing a conventional bilayer GDL 603a; CRM based MEA5s employing a CRM and conventional bilayer GDL comprising 603b and 603d curves respectively; and based MEA5s employing a porous PEM with heterogenous hGDL comprising 603c and 603e curves respectively. As an example, a 100 μm thick Nafion® film using a conventional GDL dissipates 12 W to deliver only 11 W of load power as depicted by curve 603a. Alternatively CRM can deliver 14 W as per curve 603b without a hGDL; 15.5 W as per curve 603d with a hGDL; 16.3 W as per curve 603c without a hGDL; and 17 W as per PEM+ curve 603e with a hGDL based porous membrane. Delivering 17 W to a load at 5 W power loss using the PEM+ membrane and assembly is significantly beneficial compared to 12 W dissipated delivering 11 W as per curve 603a.

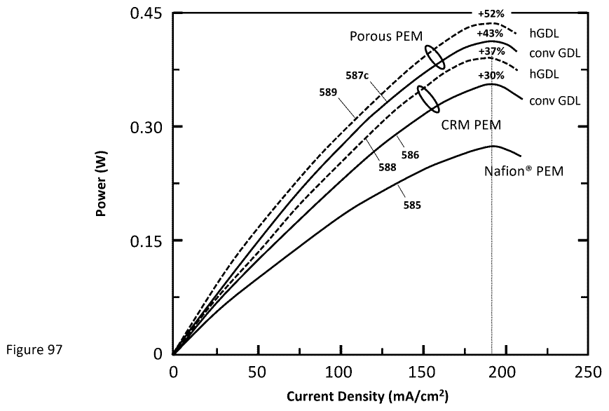

FIG. 97 illustrates power output as a function of PEM current density. The graph contrasts the power output of 100 μm Nafion® PEM 585 against various four different 20 μm films comprising CRM PEM 586, CRM PEM+ with hGDL 588, porous PEM+ with conventional GDL 587c, and porous PEM+ with hGDL 589. Compared to Nafion® PEM 585, the power delivered by the various membranes and MEA5 assemblies increase power densities by +30%, +37%, +42%, and +52% respectively. This means the power dissipation in a fuel cell can be reduced by half using embodiments of the invention disclosed herein.

### MEA7 Assembly.

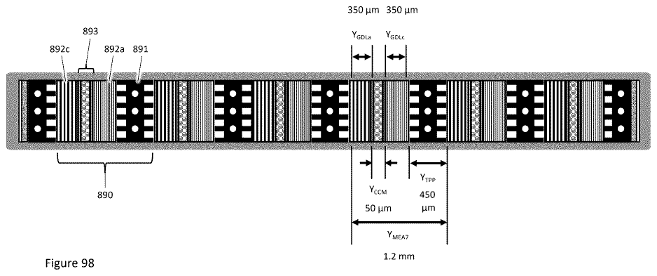

After singulation, individual five-layer MEA5s made in accordance with this invention are assembled into a fuel cell stack with intervening tripolar plates to form a seven layer MEA7 790as depicted in FIG. 98. As shown, each seven-layer MEA7 890 includes a three-layer MEA3 core 893 or CCM. In one exemplary embodiment the thickness Y_{CCM} of CCM is 50 μm. The MEA3 cores are sandwiched by an anode gas diffusion layer 892s and a cathode gas diffusion layer 892c. On one embodiment the gas diffusion layers comprise heterogenous material with multi-layer or graded porosity deposited on a thin MPL thereby forming a hGDL.

In one exemplary hGDL, the total thicknesses Y_{GDLa} and Y_{GDLc} are each 350 μm. The MEA5 assembly is sandwiched between two TPP tripolar plates 891. In one exemplary version the tripolar plates 891 are comprised of graphite or composite materials with a total thickness Y_{TPP} of 450 μm. The resulting thickness Y_{MEA7} of the exemplary seven-layer MEA7 assembly is 1.2 mm.

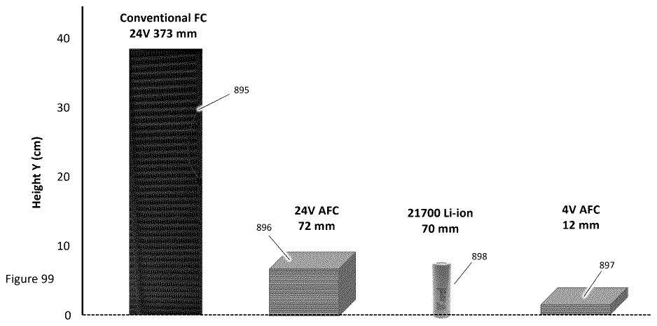

Implemented using the exemplary MEA7 design FIG. 99 illustrates a sixty-layer 24V fuel cell stack 896 of 72 mm and a ten-layer 4V fuel cell stack 897 of 12 mm height contrasted against the height 700 mm tall 21700 lithium ion cell 898. In comparison a conventional 24V fuel cell 895 with steel bipolar plates has a stack height of 373 mm, over five times thicker than the fuel cell made in accordance with this invention.

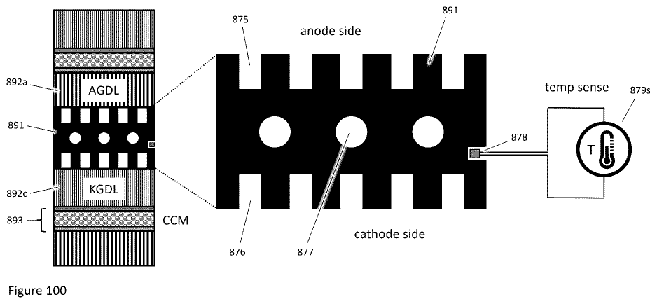

In addition to reducing height of the fuel cell stack, the thin graphite tripolar plates offer reduced electrical resistance, improved thermal conduction, and unlike steel plates are corrosion resistant. As shown in FIG. 100, in addition to cathode and anode gas channels 876 and 875 respectively, tripolar plate 891 includes a small compartment 878 located on the exterior edge of the TPP positioned closer to the cathode surface. In one embodiment of this invention a temperature sensor such as a thermistor or semiconductor temp sense IC is inserted into the enclosure and secured by adhesive. The temperature sensor can be used to monitor the heat generated in the fuel cell by providing real time temperature monitoring 879s. Temperature in the fuel cell is affected by cathode air flow and coolant circulation as well as thermal conduction into the backplane holding the iBFC modules.

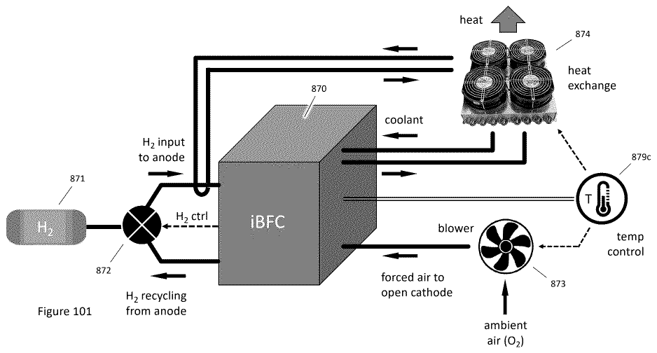

Alternatively the in situ temperature sensor may be used for active cooling in conjunction with dynamic temperature control circuit 879c as shown in FIG. 101. In this case, temperature control 879c adjusts operation of heat exchanger 874 to regulate the fuel cell temperature in iBFC 870. It also controls air circulation in the cathode iBFC 870 fuel cell by regulating blower 873. Cathode air flow affects the fuel cell operation as well as providing added cooling. Although hydrogen 871 also flows into 870 and the unused gas is recirculated, hydrogen flow is pressure and flow rate regulated 872 for proper fuel cell operation, not for temperature.

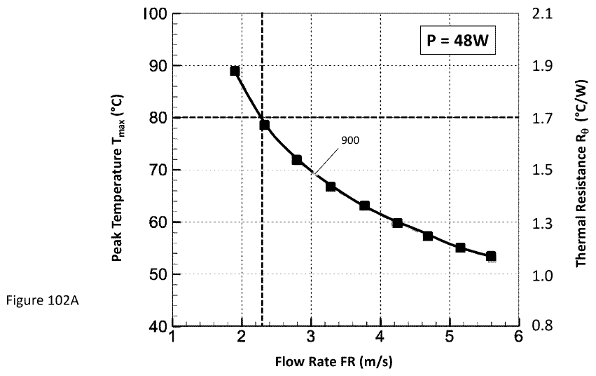

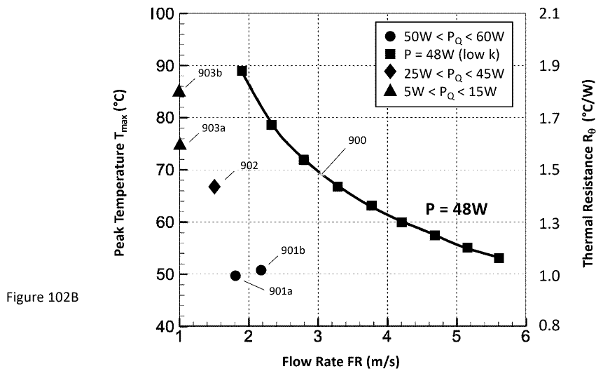

Power dissipation is a fuel cell depends on the heat generation in the membrane and in the ability of a bipolar or tripolar plate to remove the generated heat. Although many variables must be considered to correlate thermal impedance where θ=(P_{Q}/ΔT) to design and operating conditions of a fuel cell the general trend comprises a monotonic inverse, i.e. hyperbolic relationship 900 as depicted in FIG. 102A for a 48 W source using low thermal conductivity materials. Notice for a 48 W fuel cell, the curve indicates a minimal air flow rate of 2.2 m/s to maintain an 80° C. maximum membrane temperature in a 25° C. ambient. As such, a 3 m/s minimum FR flow rate for air cooling is recommended for reliable operation.

In contrast the table below includes reported values of airflow rate, heat generation, and measured peak temperature for higher conductivity materials. According to studies, thermal resistance θ ranges from 0.9-to-1.3° C./W for airflow rates over 1.4 m/s represented by points 901a and 901b and from 1.6-to-1.8° C./W at lower flow rates shown by points 902, 903a, and 903b. This thermal impedance does not include the benefit of the low stack height of a μstack and thin bipolar plates.

Overlaying the two data sets in FIG. 102B, using poor thermal conductivity materials causes higher temperatures irrespective of air flow rates. It also provides an estimate of the worst case thermal resistance useful as an upper bound in the design of air cooled fuel cells. Notice that the ratio P_{Q}/AF of dissipated power P_{Q} to the air flow velocity AF does not correlate well with the observed thermal resistance θ. This poor correlation highlights the fact thermal resistance and power dissipating capability of a fuel cell includes both convection and conduction both of which vary with temperature, air flow, surface area, and hydrodynamics, i.e. the formation of convective cells involving viscous or laminar flow. In general, thermal conduction carries 5% to 15% of the heat removed with the remainder involving thermal convention, either forced convention or natural convention. Convective cooling depends heavily on design.

The two most important design parameters to maximize convective cooling is surface area and airflow. If the surface area of a heat source is too small there is inadequate atoms involved in the heat exchange process whereby cooling will be limited and the resulting thermal resistance will be high. Conversely if the air is still atop a convective surface heat exchange will also be limited. Air removal of heat can occur in two ways, through self convection forming local loops of heat transfer and forced air convection where a fan or blower maintain a continuous supply of cool air to absorb generated heat. Both self convection and forced air cooling require adequate space above the heat dissipating surface for air to flow. If the gap between a heat source and enclosure is too tight air flow will be impeded an excessive heating will result.

| Air Flow (m/s) | P_{Q} Heat (W) | P_{Q}/AF | Temp T (° C.) | Temp Rise ΔT (° C.) | Thermal θ (° C./W) |
|---|---|---|---|---|---|
| 2.19 | 37.7 | 17 | 65 | 40 | 1.06 |
| 1.76 | 55.7 | 32 | 76 | 51 | 0.92 |
| 1.63 | 27.6 | 17 | 61 | 36 | 1.30 |
| 1.45 | 29.1 | 20 | 67 | 42 | 1.44 |
| 0.95 | 6.3 | 7 | 35 | 10 | 1.59 |
| 0.94 | 13.7 | 15 | 50 | 25 | 1.82 |

Data extracted from “Thermal analysis of air-cooled PEM fuel cells,” Intl J H₂ Energy Dec 20212.

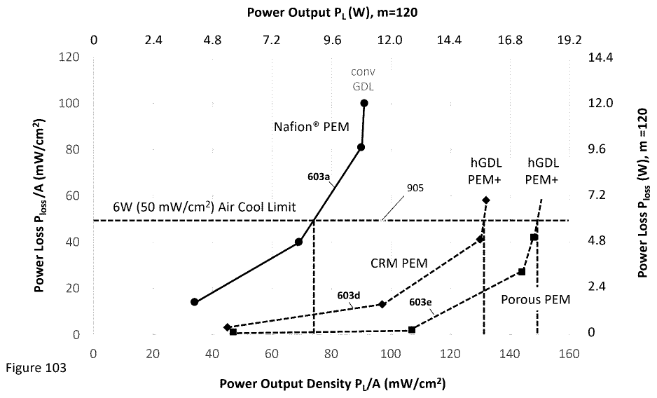

Applying the foregoing criteria to a n=8 m=120, i.e. 8s120p fuel cell design means for each cell in the stack P_{FC}=P_{Qmax}/n=48 W/8 6 W. Comparing this maximum P_{FC} power to the power loss to power output curves of FIG. 103 shows the 6 W limit 905 corresponding to a power loss density of 50 mW/cm². As shown by curve 603e, a PEM+fuel cell comprising a porous membrane plus a hGDL heterogenous gas diffusion layer is able to deliver 150 mW/cm² or 18 W per cell without exceeding the air-cooled 6 W thermal limit of 50 mW/cm².

Similarly curve 603d illustrates the slightly lower performance of a PEM+fuel cell comprising a CRM composite reinforced membrane with a hGDL heterogenous gas diffusion layer is able to deliver 130 mW/cm² or 15.6 W per cell without exceeding the air-cooled 6 W thermal dissipation limit per cell, a 13% reduction in power capability compared to the porous PEM+film.

In dramatic contrast, Nafion® PEM curve 603a confirm the 6 W/cell air cooled dissipation limit occurs at a power output of 75 mW/cm² or only 9 W/cell, a 50% reduction in air-cooled power delivery capability compared to the porous PEM+ membrane and a 42% reduction in output power compared to a CRM PEM+ membrane. FIG. 103 also overlays the 48 W, 50 mW/cm² air cooled thermal limit onto the graph of power loss versus power output The total converted power input per cell equals the sum of the output power and power loss. Specifically, the Nafion® PEM delivers 9 W from a 15 W input at 60% efficiency, the CRM PEM+delivers 15.6 W from a 21.6 W at 72% efficiency, and the porous PEM+delivers 18 W from 24 W at 75%.

| | Parameter | | | | | | | | | |
|---|---|---|---|---|---|---|---|---|---|---|
| | Pₒᵤₜ/A | Pₗₒₛₛ/A | mA_{FC} | I_{FC} | Pₒᵤₜ | Pₗₒₛₛ | n | V_{FCmin} | Pₒᵤₜ | Pₗₒₛₛ |
| | Units | | | | | | | | | |
| | mW/cm² | mW/cm² | cm² | A | W/cell | W/cell | ns | V | W/stack | W/stack |
| Porous | 150 | 50 | 120 | 24 | 18 | 6 | 6 | 0.58 | 108 | 36 |
| PEM+ | | | | | | | 8 | 0.44 | 144 | 48 |
| | | | | | | | 10 | 0.35 | 144 | 48 |
| CRM | 130 | 50 | 120 | 24 | 15.6 | 6 | 6 | 0.58 | 94 | 36 |
| PEM+ | | | | | | | 8 | 0.44 | 125 | 48 |
| | | | | | | | 10 | 0.35 | 125 | 48 |
| Nafion ® | 75 | 50 | 120 | 24 | 9 | 6 | 6 | 0.58 | 54 | 36 |
| PEM | | | | | | | 8 | 0.44 | 72 | 48 |
| | | | | | | | 10 | 0.35 | 90 | 48 |

Assuming that the fuel cell stack must output a voltage at least 3.5V then for a n=8 stack, the condition can be met for fuel cell voltages V_{FC}≥0.44V. According to the aforementioned thermal analysis, power loss is limited to 48 W for the fuel cell stack or 6 W per MEA7 cell. In this way a n=6 stack at the same power density thereby dissipates 36 W. A fuel cell stack where n=10, the power loss should be 60 W for liquid cooled cells. If air cooling is employed, the power remains limited to 48 W or 4.8 W per cell, not 6 W.

When direct thermal conduction into a temperature regulated backplane is included the thermal resistance is dramatically improved. For example a 120 cm² fuel cell comprising a 12-layer μstack with a 450-μm thick graphite bipolar plate and a total per layer thickness of 1.2 mm has a net thickness of 14.5 mm. The corresponding thermal resistance of a single layer is 0.014° C./W. For a 12-layer μstack the thermal impedance increases to θ_{FC}=0.17° C./W, a value one-order-of-magnitude lower than air cooling. Assuming a T_{FC}(max)=85° C. and a backplane temperature T_{bp}=25° C., with a ΔT_{FC}=60° C. corresponding to P_{FC}=ΔT_{FC}/θ_{FC}=(60° C.)/(0.17° C./W)=352 W, a value triple the best case air cooling example.

### IEM Membrane Fabrication.

The previous sections exemplify the formation and operation of homogeneous of PFSA and heterogenous composite reinforced membranes of a PFSA coated film of PTFE. Although these films are representative of ionomers useful in cation conducting fuel cells and electrolysis they are by no means intended to be limiting in beneficial features of the improved ion exchange membranes (IEMs) made in accordance with this invention.

In general, all ion exchange membranes suffer an intrinsic tradeoff between structural rigidity and electrical conductivity. The more conductive a film is, the weaker the mechanical support of the membrane becomes. Film conductivity may be improved by (i) thinning the membrane thickness, (ii) increasing the density of pendants to increase the molar concentration of ionomers in the matrix, (iii) increasing the hydrophilicity of the material to enhance water-carrier transport, and/or (iv) increasing the porosity of the membrane. In every case described, the mechanical strength of the film is compromised by replacing stronger hydrophobic backbone polymeric chains with weaker electrically active pendants.

The resulting weaker polymeric matrix adversely impacts the process of membrane fabrication and complicates the handling of films in the assembly of fuel cells or electrolysis units in order to avoid damaging the membrane. A thinner or weaker membrane also adversely impacts film durability, environmental resilience to temperature and humidity cycling, and operational longevity, i.e. membrane reliability. In particular, weaker film are more easily damaged during humidity cycling, power cycling, or a combination thereof.

In humidity cycling the IEM is subjected to operation during alternating cycles of low humidity, i.e. arid conditions, and high humidity. During humidity cycling water retention causes a mechanically unsupported film to swell like a sponge. During drying out periods, the film contracts causing stress on the hydrophobic backbone of the film. After numerous cycles, cracks appear in the molecular fabric of the film leading to membrane failure and leakages of gas and charges through the damage zones. Eventually the film fails altogether.

In power cycling, the IEM is operated in repeated cycles conducting high current density and low current density. At high power conditions, generated heat causes expansion of the center portions of a fuel cell stack aggravated by excess water produced in regions of high current density. Differential temperature coefficients of expansion among the various elements within a fuel cell, e.g. the CCM, GDL, bipolar and tripolar plates, and fuel cell stack end caps, result in film stresses on the membrane. Such cyclic operation can cause stress fractures in the polymer leading to immediate or latent failures. The combination of the humidity cycling and power cycling further exacerbates the problem by repeatedly subjecting the film to simultaneous high current densities at high humidity levels followed by cycles of cold arid conditions. The only means to overcome these intrinsic deficiencies of an ion exchange membrane is by improving the strength and durability of the film by reengineering its design.

Although the film and its mechanical elasticity properties are specific to the chemistry of the ion exchange membrane several key inventive features of an improved IEM made in accordance with this invention apply to all film compositions. These embodiments comprise the following:
A structural endoskeleton made in accordance with this invention forming a grid-like network throughout the membrane laterally providing mechanical support to the more fragile or thinner electrically-active ionomer film, and limiting swelling and shrinkage of the membrane from humidity cycling or during operation thereby improving film stability, reliability and cycle life.
A mechanism to control the microporosity of the IEM without fundamentally changing the chemistry of the resulting matrix. Made in accordance with this invention, the method may include temporarily introducing a soluble filler such as sugar during film polymerization and then removing the sacrificial filler with a solvent such as water after the film polymer is formed or cured. As such, sacrificial fillers comprising a large molecule present during membrane formation and subsequently removed increase film porosity by reducing the density and crystallinity of the membrane as made. Increased porosity enhances charge transport and ionomer conductivity. Conversely, permanent fillers are molecules introduced during casting or subsequent to molding that remain in place after fabrication. Unlike sacrificial fillers which are exclusively intended to increase film porosity by creating more channels within the matrix, permanent fillers can either increase or decrease membrane porosity. Specifically, permanent fillers that disrupt the periodicity, regularity, and crystallinity of a polymer during molding cause defective regions of amorphous material to be formed. These low-density amorphous ‘defect’ regions exhibit higher permeability than their higher-density crystalline counterparts, and therefore enhance proton transport and conductance. Examples include the introduction of porous silica, alumina, silicates, graphene oxides, perfluoro-dimethyldioxole (PDD); or poly(perfluoro-methylene-methyl-dioxolane) (PFMMD) into the monomer blend prior to casting. Alternatively, post mold processing of a membrane by the selective application of coatings or molecular glues like PVA clog pores present after molding, reducing the channels into the membrane electrolyte. In so doing the permanent filler reduces film porosity, beneficially limiting oxygen back diffusion and fuel crossover, especially important to prevent methanol diffusion in a DMFC.
Molecular glue comprising alcohols or solvents such as PVA where in heterogenous films the glue functions as an chemical intermediary between molecules incompatible for direct bonding. Made in accordance with this invention, examples include solvents able to bond hydrophobic and hydrophilic materials together either between dissimilar elements within a CMR composite reinforced membrane such as a PFSA-PTFE film or at the interface between the ionomer film and the IEM's endoskeleton.
Nanocoating covering the ionomeric membrane forming an interfacial layer between the membrane and the catalyst layer. Made in accordance with this invention a nanocoating may reduce the influence of dangling bonds and interfacial charge states on film conduction, enhance catalytic activity, control CCM porosity and gas transport while minimizing oxygen back diffusion and fuel crossover. The coating can also mitigate the adverse impact of atmospheric contaminants such as carbon monoxide by gettering airborne gasses and particulates which otherwise may disable or poison CCM catalysts. The nanocoating may comprise chemical components present in the catalyst layer and in lower concentrations, chemical constituents of the ion exchange membrane. Alternatively the catalyst and nanocoating can be merged into a single heterogenous layer.
Fillers & Dopants Aside from sacrificial and permanent fillers described above; fillers and dopants made in accordance with this invention comprise carbon fillers such as functionalized carbon nanotubes (CNTs) and graphene oxides (GO); oxide fillers such as silica and metal oxides; polyhedral oligomeric silsesquioxanes fillers such as POSS and DDSQ; nanostructures comprising nanoparticles, nanoclusters, and nanofibers; fillers of metal oxide frameworks (MOFs) comprising ionomers, catalyst and scavenger metals and guests; along with solid acids and proton ionic liquids (PIL).

In the context of fuel cells, the last bulleted item ‘Fillers and Dopants' describes processes that change the function of an ionomeric polymers. In chemistry, the term ‘filler’ as defined by Wikipedia “particles added to resin or binders (plastics, composites, concrete) that can improve specific properties, make the product cheaper, or a mixture of both. The two largest segments for filler material use is elastomers and plastics.” Similarly, Wikipedia defines dopant as “a small amount of a substance added to a material to alter its physical properties, such as electrical or optical properties.” A variety of permanent fillers are described here below:

### Carbon Fillers.

Examples of functionalized carbon include carbon nanotubes (CNTs) coated with sulfonic acid (SO₃H), carboxyl groups (COOH), hydroxy-phosphorus (P—OH), amino groups (—NH₂), silica (SiO₂), and titania (TiO₂). Examples of functionalized graphene oxides (GO) include polybenzimidazole grafted graphene oxide (ABPBI-GO), sulfonated polysulfone functionalized polymer graphene oxide (FPGO-sPSf, FPGO-sPSU), and perfluoropolyether grafted graphene oxide (PFPE-GO).

### Oxide Fillers.

Oxide fillers comprise inorganic and metallic oxides and complexes thereof. Examples of silica and silicates include silica (SiO₂), alumina-silica zeolite ((Al₂O₃)ₓ·(SiO₂)_{y}) and mordenite, sulfonated zeolite, nesosilicates ((SiO₄)⁴⁻), silica mesostructured cellular foam (silica MCF), phosphorylated hollow mesoporous silica (HMS-PA), sulfonated hollow mesoporous silica (MCF-SA), or amino or sulfonated hollow mesoporous silica bonded onto a sulfonated polyether ether sulfone polymer (sPEES-MCF-NH₂, sPEES-MCF-SA).

Examples of metal oxides and inorganic metal frameworks include bismuth molybdate (Bi₂MoO₆), Al-grafted mesoporous silica (MCF-ionomer), poly(m-phenylene-bibenzimidazole) doped mesoporous silica cellular foam (mPBI-MCF), zirconium-dopamine composites and intercalant zirconium with OH, O and X termini. Other inorganic metal oxide include clusters of phosphotungstic acid treated silica (PWA-SiO₂).

### Oligomeric Silsesquioxanes Fillers.

Examples of functionalized polyhedral oligomeric silsesquioxanes (POSS) include thiol coated POSS-SH, phosphoric POSS-S-PA, polyethylene glycol POSS-PEG, isobutyl POSS-iBu, vinyl POSS-Vi, chlorobutane POSS-8Cl, octakis(dimethylsilyloxy) Ot-POSS, octavinyl OV-POSS, octaphenyl OP-POSS, isobutyl-vinyl POSS-iBu-Vi, isobutyl-butylamine POSS-iBu-NH₂, isobutyl-CI POSS-iBu-CI, isobutyl-hydroxide POSS-iBu-3OH, isobutyl-styryl POSS-iBu-styryl, isobutyl-polystyrene POSS-iBu-PS and for generic radicals R the styryl and polystyrene forms POSS-R-styryl and POSS-R—PS.

Other functionalized versions include cyclopentyl-polystyrene POSS-Cp-PS, cyclohexyl-polystyrene POSS-Cy-PS, aminopropylisobutyl POSS-Am—NH₂, mercaptopropyl-isobutyl POSS-SH, and mono-(acryloisobutyl) POSS-A. Structural variants of oligomeric silsesquioxanes include double-decker topographies DDSQ functionalized in non-methylated and methylated forms NMe DDSQ and Me DDSQ, with optional functional groups including vinyl, methylpropyl, methyltrichlorosilane, dichloromethylvinylsilane, stereo vinyl, allyloxytrimethylsilane, propyl glycidyl ether, bromostyrene, and acetoxystyrene.

### Nanostructure Fillers.

Examples of nanostructure fillers include nanoparticles, nanospheres, nanoclusters, and nanofibers. Nanostructures include sulfonated poly(methyl methacrylate) nanospheres (sPMMA NS) and porous nanospheres, poly methyl methacrylate sulfonated zinc nanoclusters (PMMA ZnS NCs). Nanosphere functionalized carbon nanotubes combine the structural stability of single and multi-walled CNTs with the catalytic and ionomeric activity of functionalized nanospheres. Example include platinum-amino and titanium-amino functionalized nanoparticle coated carbon nanotubes Pt—NH₂ NP-CNT and Ti—NH₂ NP-CNT as well as phosphorated titania carbon nanotubes PO₄TiO₂ CNTs.

Made in accordance with this invention, nanofibers produced by electrospinning followed by crushing to control fiber length and porosity include poly sulfonated polystyrene nanofibers (sPS). Silver nanoparticles (Ag-NPs) may also be attached to a titanium-dopamine matrix using a sol-gel process. Other nanostructures include zirconium nanosphere Zr NS, also based on a polydopamine scaffold, and Mo—W nanoparticles derived from phosphotungstic acid. Alumina-silica zeolite ((Al₂O₃)ₓ·(SiO₂)_{y}) nanoparticles may be loaded with metal catalysts. Another class of nanostructure filler as described comprises platinum titanium dioxide nanoparticles (Pt-TiO₂ NPs).

### Metal Organic Frameworks (MOFs).

Examples of metal organic frameworks (MOFs) include convex, cluster, concave, rectangular array, trapezoidal, reflected trapezoidal, hexagonal drum, and octahedral drum geometries with functional sidechains and guest molecules. Other less periodic geometries include zinc-oxide hexaphosphate ester-based metal-organic frameworks and related chemistries. Metals may include elemental atomic titanium, platinum and palladium or metal complexes of zirconium(IV) chloride, zinc acetate, sulfonic ferrous or chromium terephthalate metal clusters. Made in accordance with the invention scavenger metals including lower-cost iron, cobalt and nickel provide catalyst protection from toxins such as NO may be substituted for catalyst metals on the MOF frame, attached to the organic ligands, or bound to a guest molecule.

Heterogenous metal organic bonds between catalyst and scavenger metal requires inventive organic ligands not used in conventional MOFs. They include dithiolene, ethanedithiol, pyridoxal-thiosemicarbazone, bis(diphenylphosphino)ethane, Schiff base, imidazophenanthroline carboxylate, ethylenediamine, salicylaldehyde, succinate, bidentate phosphine, and bipyridine. A organic alternative to MOF fillers includes triazole grafts onto the polymer's mainchain such as poly(oxy-diphenylether-bibenzimidazole) (OPBI-TG). A special category of metal framework—zeolitic imidazolate frameworks aka ZIFs comprises tetrahedrally coordinated transition metal ions such as Zn, Co, or Cu bridged by imidazole or imidazolate type linkers (Im).

### Solid Acid Fillers & PILs.

Examples of solid acids include the organic acids such as carboxylic acids (e.g. trimesic acid), oxalic acid, tartaric acid, citric acid, ascorbic acid, and maleic acid and the inorganic sulphamic acid. Being crystalline at room temperature, the acids do not leak nor rearrange the membrane matrix during power cycling. For example bismuth trimesic acid (BiTMA) can be incorporated into a membrane to enhance conductivity without compromising film durability.

Alternatively polymers can be doped with ionic liquids as a dopant. An ionic liquid is a salt in its liquid state at ambient conditions. General agreement defines an ionic liquid as a salt with a melting point below 100° C. at normal pressures. Unlike most liquids such as water, alcohols, and fossil fuels that are electrically neutral covalently bonded molecules even in their liquid state, ionic liquids are primary made of ions and therefore more chemically reactive and electrically conductive than their covalent counterparts. Ionic liquids (ILs), aka liquid electrolytes or ionic fluids, alter the conductivity of ionomeric membranes.

ILs come in two forms—cation ionic liquids and anion ionic liquids. Cation ionic liquids or CILs are derived from salts comprising methylimidazole, imidazolium, pyridine, and quaternary ammonia. Anion ion liquids or AILs are derived from tetrafluoroborate, hexafluorophosphate, bis-trifluoromethanesulfonimide, trifluoromethanesulfonate, dicyanamide, hydrogen sulphate, ethyl sulphate, and butyl-methylimidazolium tetrachloroferrate. A special form of ionic liquid is a protic ion liquid (PIL) comprising a mix of acid and base capable of reversible reaction involving proton (H⁺) exchange. In conjugate acid-base reactions, when an acid donates a proton it leaves behind a less positively charged conjugate base. As a coupled reaction, when the base receives the proton becomes a more positively charged conjugate acid. This acid-base reaction differs from simple redox reactions where ionization involves only the transfer of electrons.

PILs adaptable for use ionomeric polymers and fuel cells include alkyl imidazolium bis-(trifluoromethylsulfonyl)imide ILs. Similarly, polymer ionic liquids aka poly-ILs comprise polymerizable functional groups such as vinyl or allyl groups with repeated monomeric units connected via a polymeric backbone. In operation ILs can enhance the efficiency of the oxidation reduction reaction (ORR) in the cathode of a PEM hydrogen fuel cell increasing conductance and reducing catalyst aging.

### IEM Summary.

Made in accordance with this invention, an ion exchange membrane incorporating fillers and dopants including any of the above enumerated inventive features of carbon fillers, oxide fillers, POS fillers, nanostructure fillers, MOF fillers, and solid acid fillers and PIL dopants; or combinations thereof enable a myriad of potential performance improvements in ionomeric polymers. These innovations can be used separately or in combination. Because the chemical processes used to fabricate two different polymers are often times mutually incompatible or unable to form chemical bonds, the inventive combinations discussed herein are not obvious.

Aside from the described membrane chemistry, other processes and apparatus made in accordance with the invention to produce a fuel cell's seven-layer membrane electrode assembly (MEA7) include fabrication of an endoskeleton, control of IEM microporosity, and polymer bonding as described in the subsequent sections.

### Endoskeleton.

By providing a endoskeletal grid surrounding panes of ionomer the ionomer cannot swelling laterally within the plane of the film. Furthermore, because the membrane remains compressed from iso-planar pressure of the endoskeleton, then vertical displacement from membrane swelling is also constrained. If the molecular matrix cannot swell, then there is simply no excess compartments in which water can agglomerate during operation. In this manner the endoskeleton provides mechanical regulation of water content within the film independent of the membrane's polymer chemistry. Various methods to reproducibly form endoskeletal support comprising a grid-like structure. The endoskeleton is further reinforced by a wider exoskeletal grid subdividing the matrix into separate discrete IEMs. The entire matrix is circumscribed by a thicker wider pillar, a matrix frame, to improve mechanical durability.

### IEM Microporosity.

Given that that membrane structure is supported mechanically by the endoskeleton during operation, then ionomer charge hopping and IEM conductivity can be regulated by controlling microporosity of the membrane. Micropores comprise the natural crevasses present within a polymeric matrix where water and ions, either protons or hydroxyl ions may pass. In pure polymerization of a homogenous ion exchange membrane, only the unreacted monomers are loaded into a mold or casting unit whereby the film molecular density is determined by chemical bonding of specific length chains of the backbone and the sidechains. By contrast by introducing a sacrificial filler into the mold, the polymeric density is lowered by presence of the filler occupying intermediate locations within the matrix during polymerization.

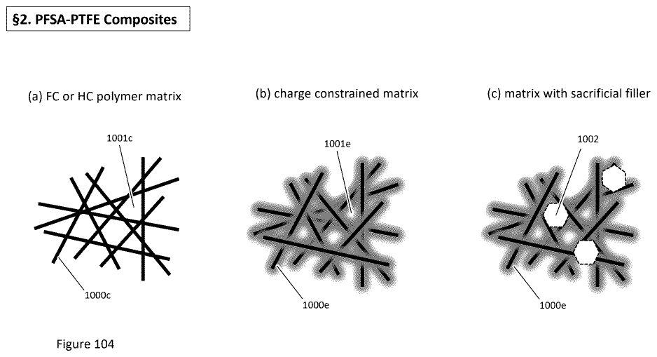

Features of the intercalated sacrificial filler are exemplified in FIG. 104 by contrasting the same polymeric matrix including and absent the filler. Specifically in the left graphical schematic labelled (a), a simplified rendition of a pristine polymer is illustrated depicting a number of overlapping the carbon backbones 800c. The matrix may for example be formed by cross linking monomers loaded in a mold without any intercalating filler and subsequently polymerized under conditions of elevated temperature and/or pressure.

In this schematic representation, atomic bonds to other atomic species such as fluorine in polytetrafluoroethylene (PTFE) or polyfluorinated sulfonic acid (PFSA) or chlorine in polychlorotrifluoroethylene (PCTFE) are removed for the sake of clarity. Like panes in a stain glass window, the windows formed between the carbon backbones 800c function as pores in the membrane.

That said, this simplified rendering overstates the size of intra-matrix pores 801c. Instead in the center graphic (b) the carbon backbone 800e has been expanded to represent the real electrostatic surface of the carbon and its associated fluorine or chlorine adjuncts. The effective membrane pore size 801e in a charge constrained model of the matrix is significantly reduced. In order to increase the film porosity and pore size, an intercalating sacrificial filler like sucrose, glucose, fructose, or chitosan is included as a powder mixed with the carbon monomer prior to molding. During polymerization domains occupied by the filler leave large gaps 802 in the matrix where carbon bonding is absent. In this manner film porosity is increased improving membrane electrical conductivity.

In accordance with various embodiments of this invention, the filler must be removed by using a solvent or chemical solution that does not damage or disturb the polymer network. In general, solvent solutions comprising polar molecules dissolve solids comprised of polar molecules or salts. Conversely solvent solutions comprising non-polar molecules dissolve solids comprised of non-polar molecules. Since the polymeric backbone of the membrane comprises a non-polar molecular structure in order to include a sacrificial filler during polymerization and then subsequently remove it the filler should comprise polar molecules. By using polar sacrificial filler molecules within the non-polar membrane, the filler can be subsequently removed without damaging the polymer. For example, water can remove sugar as a filler without adversely affecting the polymeric membrane.

Alternatively, a sacrificial filler made in accordance with this invention may comprise an inorganic salt, an ester, or many other polar molecules in their solid form at room temperature. Polar molecular solids comprise geometries where one region has a net positive charge while the other portion has a negative charge, together forming an electrical dipole moment spanning an small intramolecular distance. When the electronegativity of two or more atoms in a molecule differ by more than 0.8, the more electronegative atom spatially redistributes the molecular electron cloud closer to its nucleus. This spatial redistribution creates a dipolar moment making the molecule appear charged even though the next charge state of the molecule is zero, i.e. it is not ionized. In extreme cases on imbalance the polar molecule is considered “ionic”. Examples of polar molecules useful as candidates for sacrificial fillers in ion exchange membranes include by example without limitation:
Sugar, e.g. sucrose (C₁₂H₂₂O₁₁), glucose (C₆H₁₂O₆) or fructose (C₆H₁₂O₆).
Various inorganic salts such as sodium chloride (NaCl), potassium chloride (KCl), magnesium chloride (MgCl₂), calcium chloride (CaCl₂), and potassium iodide (KI).
Molecular salts including ammonium chloride (NH₄Cl), sodium carbonate (Na₂CO₃), potassium nitrate (KNO₃), sodium sulfate (Na₂SO₄), copper(II) sulfate (CuSO₄), and sodium bicarbonate (NaHCO₃).
Salts of organic acids including acetic acid (ethanoic acid) derived acetate salts such as sodium acetate (CH₃COONa); citric acid derived citrate salts like sodium citrate (Na₃C₆H₅O₇) and potassium citrate (K₃C₆H₅O₇); lactic acid derived lactate salts such as sodium lactate (C₃H₅O₃Na) and calcium lactate (C₆H₁₀CaO₆); tartaric acid derived tartrate salts such as potassium sodium tartrate (KNaC₄H₄O₆), aka Rochelle salt; malic acid derived malate salts, including sodium malate (C₄H₅NaO₅) and magnesium malate (C₄H₄MgO₅); oxalic acid derived oxalate salts like sodium oxalate (Na₂C₂O₄) and calcium oxalate (CaC₂O₄); benzoic acid derived benzoate salts such as sodium benzoate (C₇H₅NaO₂); succinic acid derived succinate salts including sodium succinate (C₄H₄Na₂O₄) and magnesium succinate (C₄H₄MgO₄); fumaric acid derived fumarate salts like potassium fumarate (C₄H₂KO₄); phthalic acid derived phthalate salts including diethyl phthalate (C₁₂H₁₄O₄) and dibutyl phthalate (C₁₆H₂₂O₄), ascorbic acid (vitamin C) derived ascorbate salts such as sodium ascorbate (C₆H₇NaO₆) and calcium ascorbate (C₁₂H₁₄CaO₁₂); and sorbic acid derived sorbate salts like potassium sorbate (C₆H₇KO₂).

Aside from imbalances in atomic electronegatively, geometric shape plays an important role in determining if a molecule behaves as polar or non-polar in chemical reactions. In broad terms, pyramid-shaped and V-shaped molecules are generally considered to be polar whereas linear molecules are more non-polar in their behavior. The combination of electronegatively and geometry determine which solvents are best used to remove the sacrificial filler post-polymerization. While a list of every possible combination of filler and solvent is too expansive to include herein, it is generally known to those skilled in the art of chemistry which solvents dissolve various solutes.

Pragmatically, polar solvents are therefore best in dissolving polar molecules used as sold fillers during membrane formation. Mechanistically polar solvents exhibiting high dielectric constants can stabilize the positive and negative charges of solute molecules through dipole-dipole interactions and hydrogen bonding. Preferred polar-molecule solvents to dissolve polar fillers without damaging the membrane include the following:
Deionized water (H₂O). Often considered the universal solvent, water dissolves many polar substances due to its strong polarity and ability to form hydrogen bonds, but does not harm or degrade most polymers.
Methanol (CH₃OH). A polar solvent able to dissolve a wide range of polar compounds, methanol is soluble in water making it easy to rinse remaining solvent away after treatment.
Ethanol (C₂H₅OH). Similar to methanol, ethanol is a common solvent able to dissolve many polar substances but with reduced toxic compared to methanol. Ethanol is soluble in water making it easy to rinse remaining solvent away after treatment.
Acetic acid (CH₃COOH). Due to the presence of a carbonyl group (C═O) and a hydroxyl group (O—H) within the molecule, acetic acid easily forms hydrogen bonds with other molecules, enabling it to dissolve a wide range of polar and non-polar compounds without damaging polymers
Acetone (CH₃COCH₃, ace). A solvent with a medium polarity miscible with water, acetone is also good for dissolving many polar organic compounds.
Ammonia (NH₃). A polar solvent whose polarization arises from its trigonal pyramidal shape, with nitrogen (N) at the apex and three hydrogen (H) atoms at the corners of the base causing a region of partial negative charge near the nitrogen atom contrasting the more positive hydrogen atoms. Ammonia can dissolve many ionic compounds as well as other polar substances.
Dimethyl sulfoxide (CH₃)₂SO). Also known as DMSO, a solvent known for its ability to penetrate thin membranes including human skin. Care must taken in manufacturing to avoid inadvertent poisoning of machine operators by toxic substances transported by DMSO into the skin.

Other polar solvents include substances such as dimethylformamide or DMF (CH₃)₂NC(O)H); N,N-dimethylacetamide or DMAc (CH₃CON(CH₃)₂); ethylene glycol (HOCH₂CH₂OH); propylene glycol (CH₃CHOHCH₂OH); tetrahydrofuran or THF (C₄H₈O), dioxane (C₄H₈O₂); formamide (HCONH₂); glycerol (C₃H₈O₃); and pyridine (C₅H₅N). Another solvent, acetonitrile although versatile in dissolving a range of polar molecules is ill advised as is extremely dangerous causing severe health effects and/or death. Boric acid (H₃BO₃) dissolved in water may also act as a polar solvent even through it is not a polar solvent on its own. Alternatively bleach comprises a solution of sodium hypochlorite (NaOCl) in water. In a similar manner to boric acid, bleach itself is not a polar solvent on its own but inherits the ability to dissolve polar molecules from the polarized property of water. Care must be taken to completely wash all chlorine from a membrane before forming a catalyst layer as bleach is highly corrosive and oxidative substance and is therefore not recommended in CCM fabrication.

In another embodiment, temperature is used to eliminate the filler from a polymerized film. In such a case the filler may comprise a molecule with a melting point Tₘ only slightly above the temperature of formation T_{f} needed for monomer cross-linking but below the maximum allowable temperature Tₘax to avoid damage to the polymeric matrix, or algebraically where T_{f}<Tₘ<Tₘax. In this process, the solid filler is mixed with the membrane monomer, followed by polymerization at temperature T_{f}. Thereafter the film is heated to the melting temperature of the filler Tm but below the maximum safe temperature Tₘₐₓ of the polymeric matrix. During this step the filler melts into fluid and drains from the film. Alternatively the removal of the melted filler can be accelerated by using a heated solvent such as water or alcohol to help wash the dissolved filler from the membrane cavities.

Another method to use temperature as a control parameter for microporosity involves cold polymerization. In cold polymerization the temperature of the molding process is reduced with a corresponding increase in the mold pressure. The increased pressure enables polymerization of the ionomer at a lower temperature than at normal “hot” molding processes. By performing molding at a lower temperature the number of candidates for sacrificial fillers expands to include molecules with lower melting temperatures. Using cold polymerization, sacrificial fillers that might otherwise melt during hot molding can be employed. In such case a low melting temperature filler is mixed with the monomer and molded at high pressure with minimal heating. The polymerized film is then heater slightly at atmospheric pressure to melt the filler. During this step the filler melts into fluid and drains from the film. Alternatively the removal of the melted filler can be accelerated by using a warm but not hot solvent such as water or alcohol to help wash the dissolved filler from the membrane cavities.

As a completely different approach to controlling microporosity, the sacrificial filler may comprise an non-polar organic compound highly differentiated from the membrane polymer where the solvent used to remove the filler does not attack the membrane's polymeric matrix. Yet another approach employs using a powder comprising a low cost metal such as zinc or magnesium incorporated into the monomer powder. After polymerization the metallic sacrificial filler may be removed by a mild solution of hydrochloric acid.

Although the chemistry differs by the polymer used to form the membrane, the sacrificial filler used to form the micropores in the film, and the solvent used to remove the filler, the combination of chemicals used to form a microporous IEM in accordance with this invention requires the following criteria be met.
The solvent used to remove the filler must not damage the polymeric backbone of the membrane
The solvent used must not damage or degrade the electrically active charge group on the ionomer's pendant.
The solvent should not leave corrosive residues in the membrane.

### Polymer Bonding.

Another embodiment of this invention involves the use of molecular glue in fabricating the membrane. Molecular glue has two uses in the described processes—either to help adhere a hydrophilic ionomer to a hydrophobic backbone when fabricating a heterogenous composite reinforced membrane (CRM), to improve bonding between a homogenous hydrophilic ionomer and a hydrophobic endoskeleton, or to assist in cross linking of hybrid copolymers and block copolymers. In this manner the skeletal framework of a membrane may comprise entirely different plastics or composite materials than those used to form the thin ionomeric regions.

In the previous examples described herein, PVA treatment of PTFE was used to form a bridge between the hydrophobic PTFE and a hydrophilic ionomer such as PFSA. The same method can be applied to adhere a homogenous PFSA film to a PTFE pillar forming an endoskeleton. In this manner a molecular glue functions as if to cleave or clear certain areas of ionic charge causing localized hydrophobicity, replacing it with a bonding site for attaching sidechains, a process referred to as chemical grafting. In such an instance the sidechain functions as a buffer to physically separate the hydrophilic ionomer from the hydrophobic backbone. In reality, grafting PTFE to perform molecular gluing is a complex process and not simply an atomic substitution in the mainchain. This struggle to glue material onto a preformed film of PTFE is the consequence of its complete covalent bonds, a reason for it be criticized as an indestructible “forever chemical” dangerous to the environment.

In conclusion, very few solvents can degrade PTFE. According to the CP Lab Safety website it is because polytetrafluoroethylene (PTFE) is very non-reactive that renders it ideal for use with most chemicals. The only listed substances that degrade PTFE to any degree include chlorobenzene (mono); diethylamine; fluorine; gallic acid; gold monocyanide; lead sulfamate; mercuric cyanide; naphtha; as well as fuel oils, gasoline, and petroleum. Theoretically these agents could be used to treat PTFE to create graft points but care would be required not to degrade film stability.

An alternative mechanism to create graft points on a non-reactive hydrophobic backbone like PTFE can be achieved by treating the surface by a plasma or alternatively by sputter etching. Plasma etching is the process where a RF field is used to stimulate a gas to create a sea of chemically reactive ions which subsequently attack the target etch surface. Variables include the gas species used to create the plasma etchant ions, control of the chamber vacuum, pressure, and temperature, as well as the RF source power and oscillation frequency.

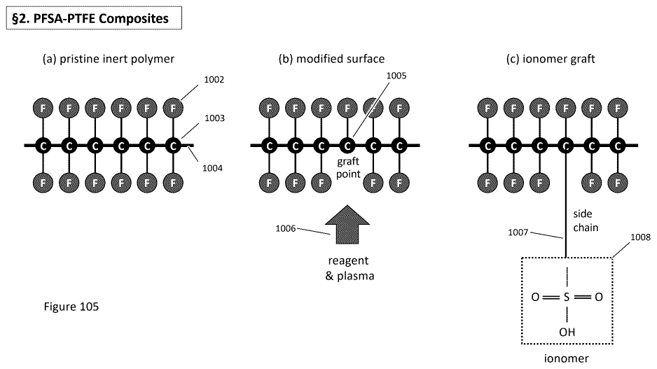

FIG. 105 graphically represents the process of grafting an conductive ionomer such as PFSA onto a hydrophobic inert fluorocarbon polymer. Starting with a pristine polymer shown in the left graphic labeled (a), PTFE comprises a mainchain backbone 810 with a string a carbon atoms 811 completely bonded to fluorine 812. This complete covalent bonding renders PTFE inert, stable, electrically insulating, and hydrophobic. To graft a pendant onto the mainchain, a reagent or plasma 814 strips away a fluorine atom modifying the molecular surface to expose a graft point 813 as shown in the center illustration labelled (b). In the final step labelled (c) on the right graphic a pendant comprising a sidechain 815 and ionomer 816 such as PFSA is bonded onto the graft point. The ability to graft a pendant onto the mainchain can be characterized by measuring the stability of the PTFE as quantified by required bonding force, surface tension, or surface energy of the film.

Bonding force, expressed as force in the cgs system as dynes is a measure of the attractive force a molecule, in this case the mainchain, exerts on ions to form chemical bonds, i.e. its ability to perform chemical bonding. The higher the molecular binding force the more chemically active material is. As a unit of measure one dyne equals 10⁻⁵ kg m/s² or a hundred thousandth of a newton, i.e. 10⁻⁵ N, which also sometimes is expressed as a hundredth of a milli-newton or 0.01 mN. When a film has complete covalent bonding with no dangling bonds the surface energy is low meaning it is difficult to form bonds. Untreated, PTFE typically has a surface energy less than 28 dynes or 0.28 mN. A plasma treatment for only 5 minutes increases the surface energy of PTFE to 105 dynes, far above the minimum surface reactivity of 60 dynes generally required for adhesive bonding.

Another way to characterize the reactivity of a film is in terms of surface tension or surface energy, measured in milli-newtons per centimeter or dynes per centimeter where 1 dyne/cm=0.01 mN/cm. Although they have identical units surface energy is the equivalent attractive force present between the molecules at the surface of a solid substance while surface tension is the force required to produce a displacement of molecules at a specified distance. The poor wettability of PTFE refers to the ability to bond to PTFE after dry etching either by plasma etching PE or a related method referred to as reactive ion etching (RIE). As purported, dry etching profoundly impacts surface energy and surface tension as well as affecting available molecular contact angles—the angle relative to the surface where molecular grafts may occur.

Specifically pristine PTFE exhibits a surface energy of 16 dyne/cm while plasma and RIE treated surfaces are improved by one-to-two orders-of magnitude to 0.76 dynes/cm and 0.2 dynes/cm respectively. The weaker surface bonding energy results in increased surface tension for the etched materials, enhancing wetting from 46 dyne/cm for pristine PTFE to 68 dyne/cm for PE treated films and to 74 dyne/cm for RIE processed PTFE.

Exemplary plasma process conditions ranged from RF power from 125 W-to-175 W, exposure times from 450 s-to-750 s and total gas flow rates from 60-to-100 sccm. The term ‘sccm’ is an acronym for standard cubic centimeter per minute. The reactant gasses employed comprised oxygen and argon with oxygen comprising between 50% to 80% of the mix. Other papers have reported etching of superhydrophobic surfaces such as PTFE and various plastics using other reactant gasses such as CHF₃ and SH₆.

Alternatively sputter etching, using a non-chemically reactive method of momentum transfer may be used to activate the PTFE surface for bonding. Mechanistically, plasma etching strips fluorine from the polymer exposing carbon atoms in the backbone to facilitate grafting. Unlike wet chemistry etching involving sodium ammonia or sodium naphthalene, plasma etching does not generate wet stream or liquid waste.

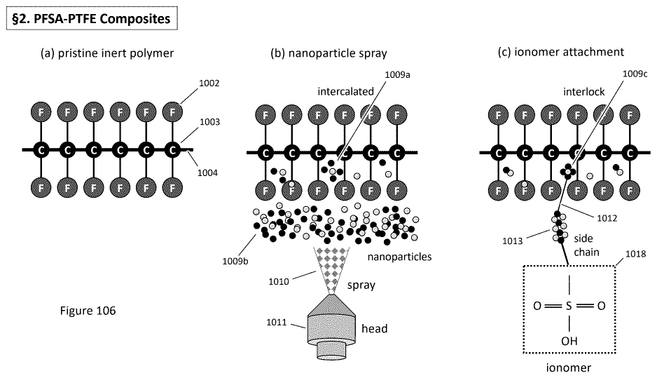

So plasma etching aside, if wet chemical etching is not effective in removing fluorine from a PTFE coated surface how then how can PTFE-PVA-PFSA composite reinforced membranes (CRMs) be fabricated? This somewhat unexpected mechanism shown in FIG. 106 involves cross linking of PVA and PTFE nanoparticles to form a mechanical bond to the film surface by ‘entanglement’. Starting with a pristine backbone of PTFE 810 comprising carbon 811 and fluorine 812 is treated by spraying 819 or coating the membrane from a spray head 820 or other applicator with a nanoparticles suspension of PVA with PTFE nanoparticles 828. Some nanoparticles 817a are able to impregnate surface-pore area of the PTFE membrane as shown in the center graphic labelled (b).

After curing sown in the right most illustration labelled (c) the nanoparticles bond with themselves forming interstitial molecules 817b within the PTFE film covalently bonded via PVA 812 to a self organizing sidechain 823 connecting to an ionomer 815 such as PFSA. Once cured the interstitial nanoparticle molecule 817b provides mechanical locking of the entangled portion of the molecule within the PFSA structure without actually grafting itself onto the mainchain. This nanoparticle interlock facilitates mechanical and electrostatic attachment between the PVA-PTFE film below the PTFE surface and the PVA cross linkage to sidechains attached to its PFSA ionomeric terminus in the pendant. In this manner the ionomer adheres to the membrane mechanically and electrostatically without restricting the mainchain or necessarily forming new covalent bonds to the carbon backbone.

Process sequences may for example comprise starting with a PTFE membrane or skeleton spraying it with PVA, washing the film with ethanol, then stimulating cross linking to the polytetrafluoroethylene surface using glutaraldehyde. Alternatively PVA may be cross linked to poly(acrylic acid-co-2-acrylamido-2-methyl propane sulfonic acid), chemically as (P(AA-AMPS)), to enhance stability. Other composite membranes involve bonding using PVA with inorganic zirconium phosphate to form a highly stable composite membrane of PTFE-ZrP-PVA.

Still another category of nanoparticle surface modification involve polyoxyethylene (POE). In this process PVA and POE polymers are blended to form nanofibers using a process of electrospinning or electrospraying, fiber and film fabrication methods involving the simultaneous application of electric fields in the film or fiber formation process. In electrospraying employs a high voltage to disperse a liquid or for the fine aerosol through a small aperture liquid jet. Varicose waves on the surface of the jet lead form small and highly charged liquid droplets radially dispersed by Coulombic repulsive forces to form the fiber or film.

In a similar manner fiber production using electrospinning employ electric force to draw charged threads of polymer solutions or polymer melts into fiber several hundred nanometers in length. The fiber formation does not require chemical cross linking or high temperatures as the energy in imparted into bonding process electrostatically. In the example described, PTFE emulsion is blended with a carrier polymer solution such as polyethylene oxide (PEO) and poly(vinyl alcohol), i.e. PVA. Subsequent to electrospraying or electrospinning, sintering in nitrogen is performed, e.g. at 390° C. to fuse the PTFE into fibers or films while eliminating the carrier polymer. By controlling the blend, surface texture and surface energy of the film as formed can be adjusted from smooth to more porous membranes having rough surfaces supporting grafting and pendant attachment.

It should be mentioned that both polyoxyethylene (POE) and polyethylene oxide (PEO) refer to polymers of ethylene oxide. Somewhat confusingly however the terms are used in different contexts as distinguished by their molecular weight. In particular used in applications as thickening agents, the highly viscous polyethylene oxide (PEO) typically refers to the polymer with high molecular weight, while lower molecular weight polyoxyethylene (POE) is commonly used as a surfactant or emulsifier. Despite these differences, both PEO and POE consist of the same repeating unit, which is the ethylene oxide monomer (—CH₂—CH₂—O—).

In another fabrication method, a PTFE membrane is formed using polytetrafluoroethylene treated by a solution of chitosan (CS) crosslinked with poly(vinyl alcohol) using epichlorohydrin (ECH). Chitosan is a linear polysaccharide formed from shellfish and crustaceans composed of randomly distributed β-linked D-glucosamine and N-acetyl-D-glucosamine. Chitosan is beneficial as a sacrificial filler in controlling film porosity in part because of its intrinsic fibrous structure. In film processing, the organochlorine compound epichlorohydrin, a toxic substance used in epoxy and miscible in polar organic solvents is employed to crosslink the PVA and chitosan followed by in situ chimeric SiO₂ nanoparticle adhesion and water rinsing and/or soaking.

The modified PTFE membrane exhibits decreased carbon (C) and fluorine (F) content with a corresponding increase in hydrophilic groups. While developed for wastewater treatment, the enhanced hydrophilicity of the modified PTFE film makes the process a potential candidate for forming heterogenous composite reinforced membranes (CRMs) such as PTFE-PVA-PFSA as well as a means to “glue” homogenous PFSA ionomers onto a plastic or PTFE skeleton.

Made in accordance with this invention other embodiments comprise polymeric endoskeletal pillars strengthened by fibers such as carbon fibers, graphene, carbon nanotubes, polyamide and other long-chain aramid fibers, derived from an aromatic form of amides. Alternatively shards of harder polymer may be employed. In this context, aromatic refers to a conjugated ring of unsaturated bonds, empty orbitals exhibiting structural stability stronger than expected by the stabilization of conjugation alone.

Examples include hexagonal rings of six carbon atoms with an associated C-O groups connecting to N-H groups via amide linkages. By commercial taxonomy, at least 85% of the amide bonds must attach to two aromatic rings to be considered an aramid. Aramid physical properties include abrasion resilience, good resistance to organic solvents, electrically nonconductive, and featuring a very high melting point. Unencapsulated aramids are sensitive to acids, salts, electrostatic charge, and ultraviolet radiation.

Used as a strengthener, various forms of fibrous carbon or amides are generally embedded in thermoset like an epoxy resin, polydicyclopentadiene, polyimide, or other plastics. By mixing the different diameter particles-fibers into fiber layers in a 2D or 3D matrix, heterogeneity can improve the strength and resilience of endoskeletal support to thin membranes ush as ionomers. For example a PTFE-PVA-PVDF conjugate made in accordance with this invention for non energy uses can be repurposed to strengthen membrane endoskeletons despite representing a different application and field-of-art. As exemplified, creative elements of this invention is not the organic chemistry of forming the polymer backbone, but how to strengthen it, enable cross polymerization and bonding between dissimilar polymeric materials, control porosity, manage ionomeric functionalization to modulate conductivity while regulating hydration and swelling.

By introducing silicon hydroxyl groups onto the surface of polyacrylonitrile or PAN, a synthetic, semicrystalline organic polymer resin with the linear formula (CH₂CHCN)ₙ, hydrophilic PAN-SiO₂ fibers can be conjugated by molding or electrospinning with hydrophobic thermoplastic polyvinylidene difluoride PVDF formed by the polymerization of vinylidene difluoride to produce (C₂H₂F₂)ₙ. The resulting PVDF-PAN-SiO₂ fibrous plastic is stronger than numerous unstrengthened polymers.

In general the challenge to bond plastics of dissimilar polymers, especially category 1 plastics comprising polyethylene terephthalate (PET), category 2 comprising high-density polyethylene (HDPE), category 4 comprising low-density polyethylene (LDPE), and category 5 representing polypropylene (PP). Adhesives suitable for gluing polyethylene or polypropylene are generally labelled as such, but may fail if the surface morphology of the plastic is too dense or insufficiently porous to facilitate coating using nanofiber compounds.

Other more wettable plastics include category 3 for polyvinyl chloride (PVC) and category 9 for acrylonitrile butadiene styrene (ABS) which generally require either a solvent adhesive or epoxy compounds. Category 6 plastics comprising polystyrene (PS) is brittle and therefore not a suitable candidate for forming endoskeletal support for IEMs. Category 7 is the miscellaneous category including polycarbonate and acrylic requiring epoxy acrylic solvent adhesive, or cyanoacrylate. Other plastics may include acetal chemically known as polyoxymethylene or POM, a semi crystalline thermoplastic with high mechanical strength and rigidity.

In yet another embodiment of this invention, the PFSA ionomer can be attached to the rigid endoskeleton using a class of chemical bonding referred to as molecular glue. While traditional adhesives bond objects by physical adsorption effects which depend on a films surface energy, using a bis-diazirine reagent bonding is achieved through the formation of strong covalent bonds through promiscuous C—H insertion, essentially clearing a region on a substrate surface the compound works by releasing N₂ upon thermal or photo-chemical activation to afford reactive carbene species capable of undergoing efficient C—H insertion with a wide range of polymer materials. Since the bis-diazirine reagent can react twice during bonding, it is able to form crosslinking delivering higher mechanical strength, improved flexibility without cracking, increased glass transition temperatures and more. Measured bonding strength between two pieces of high-density polyethylene (HDPE) exceed 2.3 MPa.

In summary, forming a heterogenous composite reinforced membranes (CRMs) such as PTFE-PVA-PFSA, grafting hydrophilic ionomers such as PFSA onto a PTFE mainchain, or bonding a homogenous film of PFSA to the polymeric skeletal structure made in accordance with this invention involve destruction of C—F bonds to accommodate bonding or grafting hydrophilic pendants onto the matrix. Alternatively application of a layer of hydrophilic coating directly on the membrane surface using nanostructure locking may be employed. While the grafting process involves the application of expensive plasma etchers or hazardous chemicals, the surface coating method is simpler and lower in cost. Unfortunately in coated membranes, micropores may be blocked reducing water flux and film conductivity.

Highly soluble in water, non-toxic, biocompatible, hydrophilic, innocuous and non-carcinogenic, polyvinyl alcohol (PVA) with its abundant hydroxyl groups is therefore beneficial as a hydrophilic additive, but requires cross-linked by another material such as glutaraldehyde to remain stable in an aqueous phase. As an alternative surface modification of PTFE, chitosan (CS) a sugar-like molecule prepared by the deacetylation of chitin can be used in conjunction with PVA to affix a PVA-CS hydrophilic layer onto the fibril surface of the PTFE.

In a similar fashion, to form a stable aqueous solution chitosan must be cross linked to PVA using a reagent such as epichlorohydrin (ECH). Another option for bonding super hydrophobic skeletons to hydrophilic ionomers such as PFSA may involve compatible fluoropolymers, i.e. fluoropolymers that are chemically similar to PFSA such as FEP (fluorinated ethylene propylene) or PVDF (polyvinylidene fluoride) through sintering or electrospraying.

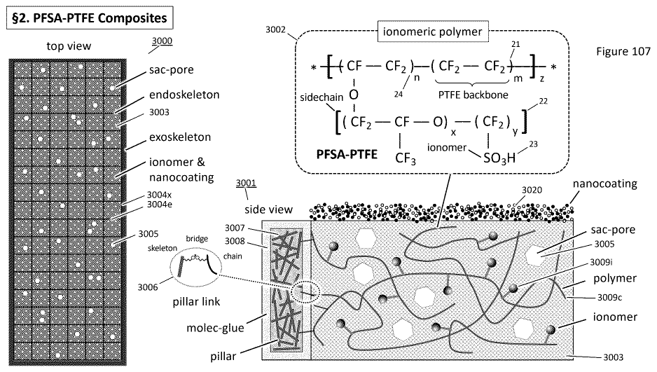

In general, chemically coating a super hydrophobic surface (SHS) with a hydrophilic layer requires a polar solvent such as PVA able to coat the SHS using electrostatic force without the need for disrupting C—F bonds. In order to form a bridge to hydrophilic molecules such as PFSA, sucrose, or chitosan, to form a stable aqueous solution however, a reagent such as glutaraldehyde or epichlorohydrin is required to facilitate cross linking between a polar molecule such as an PFSA ionomer or a sacrificial filler and the carrier solvent such as PVA, polyethylene oxide (PE) or (P(AA-AMPS)). Membrane top view 3000 and membrane side view 3001 in FIG. 107 illustrate a variety of elements of composite ionomeric polymer 3002 made in accordance with this invention, including separately or in combination inventive matter comprising
an ion exchange membrane 3003 composed of one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 formed by the introduction of a sacrificial filler prior to molding and its subsequent removal post casting by a solvent leaving a hole in its place of the sac-filler; and/or
where an optional nanocoating 3020 is formed atop membrane 3003 to either enhance membrane conductivity or provide protection against membrane poisoning including boron nitride or other materials that inhibit the diffusion of carbon monoxide (CO) into the catalyst layer;
where ionomeric polymer 3002 may comprise a blend of PFSA 24 and PTFE 22 or other homopolymers, heteropolymers, copolymers, or blends of homopolymers, heteropolymers, copolymers as a mainchain expressing varying degrees of crystallinity and anisotropy;
where ionomeric polymer 3002 may comprise varying lengths of fluorocarbon sidechains serving as pendants such as those found in Nafion®, Aquivion®, and Gore-Select® influencing crystalline regularity, porosity, conductivity ands fuel crossover of the membrane; and finally
where ionomeric polymer 3002 may comprise an ionomer 3009i of reactive sulfonic acid groups —SO₃H 23, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkyl-ammonium groups —NR4⁺; phenolic hydroxyl groups —OH, or any other acidic group which easily ionizes to donate conducting cations of H⁺, Na⁺, or K⁺ into the solid electrolyte;
where the combination of the endoskeletal pillars and the membrane coating are used to seal in any ionic liquid doping to prevent seepage, leakage, or IL depletion.

### PEM Ionomer Summary.

For positive ion charge transport known as cation exchange membranes (CEM) or proton exchange membranes (PEM) a suitable material rejects electron transport and inhibits negative ion transport but supports positive ion conduction across the membrane.

Key feature of a proton exchange membrane is a non-reactive non-conductive chemical backbone, typically a hydrophobic non-polar polymer such as PTFE attached to a network of pendants with an ionomer terminus, easily ionized to result in a net negative charge state, and thereby only capable of conducting positive ionic charge, i.e. cations. The membrane is sandwiched by thin catalyst layers comprising noble metals such as Pt or Pd and optionally metallic oxides interspersed within a carbon matrix.

On the anode the catalyst is used to strip electrons from hydrogen to form free conduction electrons and hydrogen ions, i.e. protons, in a chemical process referred to as oxidation. On the cathode side of the membrane, another layer of catalyst atoms helps promote electrical bonding among the incoming hydrogen ions, the circuitous electrons, and a reducing agent, typically oxygen. The byproduct of the reducing process is water.

The following table below considers a list of potential candidates for realizing a proton exchange membrane with good mechanical rigidity and durability, superior ion conductivity, and good specificity against anion transport and electron conduction. The table is arranged by classes of atomic structure used to form the membrane including homogenous PFSA or PFSA-hydrocarbon blends with or without sacrificial fillers; heterogenous compound reinforced membranes (hCRMs); inorganic-organic compound reinforced membranes (io-CRMs); polymer-inorganic hybrid matrix; acid-base blends; anhydrous proton conductors; bio-polymers; ionic polymers; block copolymers; radiation-grafted membranes; as well as proton conducting gels & hydrogels. While some of the listed or proposed PEM ionomers are applicable for fuel cells and electrolysis, other membranes are useful in filtration, electrodialysis, drug delivery, water purification, desalinization, and as coatings for surfaces and tubing. The following table lists the major categories of PEM membranes arranged in this application.

As shown, each § section describes a category of ion exchange membrane comprising a variety of membrane structures and a list of enhancements including numerous embodiments made in accordance with this invention, comprising for example and without limitation chemically inert endoskeletal support with reinforcing fillers such as carbon fibers and polymer shards; chemical bonding of the ionomeric membrane to reinforced pillars of the endoskeleton via polar-nonpolar linkers and molecular glues; sacrificial fillers controlling film porosity; embedded nanoparticles; metallic organic frameworks (MOFs) containing catalysts, gas scavengers, and guest ionomers; and numerous combinations thereof. Note terms with a lowercase prefix ‘s’ refer to sulfonated forms of the atoms, bit other acids such as phosphonic acid may be employed in lieu of sulphonic acid.

| § | PEM Structure | Category | PEM Enhancements |
|---|---|---|---|
| 1 | PFSA bulk membranes | PFSA | endoskeleton, pillar link |
| | | homopolymer | sacrificial filler |
| | | | nanoparticle coating |
| 2 | PFSA-PTFE | PFSA CRM | endoskeleton, pillar link |
| | PFSA-PTFE-co-PTFE | heteropolymer | sacrificial filler |
| | PFSA-PVA-PTFE | & composites | nanoparticle coating |
| 3 | perfluorodimethyldioxole (PDD) | amorphous | endoskeleton, pillar link |
| | perfluoro-methylene-methyl-dioxolane- | homopolymer | sacrificial filler |
| | sulfonic acid (PFMMD-SA) | glassy matrices | nanoparticle coating |
| 4 | sulfonated polyethylene (sPE) | polyethylene | endoskeleton, pillar link |
| | bromated polyethylene (BrPE) | (PE) polymers | sacrificial filler |
| 5 | sulfonated polyvinyl alcohol (sPVA) | polyvinyl alcohol | endoskeleton, pillar link |
| | +cellulose acetate (PVA-g-CA) | (PVA) polymers | sacrificial filler |
| | +sulfosuccinic acid (PVA-SSA) | & copolymers | crosslinked copolymer |
| | +SSA grafted PVA (PVA-co-SSA) | | |
| | phosphorylated polyvinyl alcohol (PPVA) | | |
| | +phosphorus acid (PO₃H₂-PVA) | | |
| | +phosphoric acid (PO₄H₂-PVA) | | |
| | +phosphotungstic acid (PWA-PVA) | | |
| | +trimethoxysilylpropanethiol (TSMP PVA) | | |
| | +chitosan Na-alginate PVA | | |
| 6 | polyvinylidene fluoride (PVDF-SA) | polyvinyl | endoskeleton, pillar link |
| | +polyvinyl pyrrolidone (PVDF-PVP-SA) | difluoride | sacrificial filler |
| | +azobisiso butyronitrile (PVDF-AIBN-SPA) | (PVDF) polymers | crosslinked copolymers |
| | +perfluoro-hexene (PVDF-AIBN-SPA-PFH) | & copolymers | |
| | polyvinyl alcohol (PVDF-co-sPVA) | | |
| | polystyrene (PVDF-PVP-PSSA) | | |
| | polycarbonate (PVDF-co-sPC) | | |
| | methyl-methacrylate (PVDF-co-PMMA) | | |
| | perfluorosulfonic acid (PVDF-co-PFSA) | | |
| 7 | polypropylene CRM (PFSA-co-PP) | polypropylene | endoskeleton, pillar link |
| | polypropylene CRM (PFSA-PTFE-co-PP) | (PP) copolymers | sacrificial filler |
| 8 | sulfonated polyvinyl chloride (sPVC) | polyvinyl | endoskeleton, pillar link |
| | polyvinyl butylimidazolium grafted | chloride (PVC) | sacrificial filler |
| | polyvinyl chloride PVC-g-P(VBIm) | polymers | |
| 9 | sulfonated polyimide (sPI): ODADS | polyimide (PI) | endoskeleton, pillar link |
| | sulfonated polyimide (sPI): pBABTS | polymers | sacrificial filler |
| 10 | sulfonated polystyrene (sPS) | polystyrene (PS) | endoskeleton, pillar link |
| | styrenesulfonate (sSA) | polymers & | sacrificial filler |
| | cross-linked styrenesulfonate (sSA-X) | copolymers | |
| 11 | sulfonated poly fluorenyl ether | fluorenyl ether | endoskeleton, pillar link |
| | ketone nitrile (sPFEKN) | ketone nitrile | sacrificial filler |
| | | polymers | |
| 12 | polyphenylene disulfonic acid (PPDSA) | polyphenylene | endoskeleton, pillar link |
| | polybiphenylene disulfonic acid (PBPDSA) | (PP) polymers & | sacrificial filler |
| | linear/sidechain/kinked sulfonated | copolymers | crosslinked copolymer |
| | polyphenylene (sPP) | | branched copolymer |
| | +p-benzoyl/p-phenoxybenzoyl | | |
| | post-sulfonated phenylated (SDAPP) via | | |
| | Diels Alder condensate | | |
| | pre-sulfonated phenylated PPs | | |
| | polybiphenylene-co-phenylene | | |
| | disulfonic acid (BXPY) | | |
| | sulfonated polyphenylene - biphenyl | | |
| | (SPP-BP)/quaterphenol (SPP-QP) | | |
| | sulfonated polyphenylene - triphenol | | |
| | (SPPT), meta-biphenyl (SPPBm), ortho | | |
| | biphenyl (SPPBo), naphthyl (SPPN) | | |
| | sterically hindered pyridine moieties | | |
| | sulfo-phenylated polyphenylene (X + Y)N | | |
| | branched sulfo-phenylated | | |
| | polyphenylene (sPPB-x % DB) | | |
| | hydroxylated sulfonated | | |
| | phenylated polyphenylene (sPPP-OH) | | |
| | diiodo-biphenyldisulfonic acid (DiIPS) | | |
| | dibromo-biphenyldisulfonic acid | | |
| | (DiBrDS) | | |
| | sulfonimide branched poly | | |
| | (phenylenebenzophenone) (SI-PPBP) | | |
| 13 | sulfonated polyarylene ether (SPAE) | polyarylene | endoskeleton, pillar link |
| | sulfonated perfluoropolyether (sPFPE) | ether (PAE) | sacrificial filler |
| | sulfonated polyarylene ether sulphone | polymers | graphene oxide (GO) |
| | (SPAES) | | filler, graft, crystallites |
| | | | phosphotungstic acid |
| | | | crystallites (PWA) |
| 14 | sulfonated poly ether-ether ketone | poly ether | endoskeleton, pillar link |
| | (sPEEK or PEEK-sPEEK) | ketones (PEK, | sacrificial filler |
| | sulfonated poly ether ketone (sPEK) | PEEK, PEₓK_{y}) | |
| | sulfonated poly ether ketone-ketone (sPEKK) | polymers | |
| | sulfonated poly ether-ether-ether | | |
| | ketone (sPEEEK) | | |
| | sulfonated poly ether-ether ketone-ketone | | |
| | (sPEEKK) | | |
| | sulfonated poly ether ketone-ketone-ketone | | |
| | (sPEKKK) | | |
| | sulfonated poly ether ketone ether ketone- | | |
| | ketone (sPEKEKK) | | |
| | sulfonated (poly ether ketone) - poly | | |
| | ether ketone (sPEK-PEK or 2PEK) | | |
| 15 | sulfo poly ether-ether sulfone (sPEES, SPEESf) | polymers and | endoskeleton, pillar link |
| | sulfonated poly ether-ether sulfone-co- | copolymers of | sacrificial filler |
| | poly(ether imide) (sPEES-co-PEI, sPEESf- | poly ether | bismuth trimesic acid |
| | co-PEI) | sulfones | (BiTMA) |
| | sulfonated poly (phenylene ether-ether- | poly ketone | bismuth molybdate |
| | sulfone)-poly (acrylamido-methyl- | ether sulfones | (Bi₂MoO₆) |
| | propanesulfonic acid) (SP-PMPS) | poly arylene | |
| | fluorinated polyethersulfone (FPES, | ketone ether | |
| | FPESf, FPESU) | sulfone | |
| | di-poly(arylene ketone ether sulfone) | | |
| | (2PAKESf, 2PAKES, 2PAKESU) | | |
| | poly(arylene ketone ether ketone | | |
| | sulfone) (PAKEKS, PAKEKSf, PAKEKSU) | | |
| | sulfonated poly ether sulfone - bismuth | | |
| | trimesic acid heteropolymer (SPES- | | |
| | BiTMA, SPESU-BiTMA) | | |
| | sulfonated poly ether sulfone - bismuth | | |
| | molybdate heteropolymer (SPES- | | |
| | Bi₂MoO₆, SPESU-Bi₂MoO₆) | | |
| | sulfonated quaterphenol polysulfone | | |
| | (S₄Ph-PSU, S₄Ph-PSf) | | |
| | bis-hydroxyphenyl ether sulfone | | |
| | (BHPESf, BHPES, BHPESU) | | |
| 16 | membrane agnostic dopants, incl: | hybrid polymer | endoskeleton, pillar link |
| | PFSA-PTFE CRM | with carbon | sacrificial filler |
| | PFSA-PVA-PTFE CRM | filler | carbon nanotubes |
| | sulfonated polyarylene ether sulphone | | SO₃H/COOH |
| | (SPAES, SPAESf) | | POH/—NH₂ |
| | sulfonated poly ether-ether ketone (sPEEK) | | SiO₂/TiO₂ |
| | sulfonated poly ether-ether sulfone | | graphene oxide |
| | (sPEES, sPEESf) | | PFPE-GO |
| | polyvinyl alcohol (sPVA) | | ABPBI-GO |
| | phenylene-bibenzimidazole (PBI) | | Hoffman GO |
| | chitosan (CS) | | Scholz-Boehn GO |
| | | | Ruess GO |
| | | | Lerf-Klinowski GO |
| 17 | membrane agnostic dopants, incl: | hybrid polymer | endoskeleton, pillar link |
| | PFSA-PTFE CRM | with silica filler | sacrificial filler |
| | PFSA-PVA-PTFE CRM | | HMS-PA phosphoric |
| | sulfonated polyarylene ether sulphone | | acid, hollow mesopore |
| | (SPAES, SPAESf) | | silica |
| | sulfonated polyether ether ketone (sPEEK) | | Al-graft mesopore silica |
| | sulfonated polyether ether sulfone | | silica-MCF |
| | (SPEES, SPEESf) | | mesostructured |
| | polyvinyl alcohol (sPVA) | | cellular foam |
| | phenylene-bibenzimidazole (PBI) | | |
| | chitosan (CS) | | |
| 18 | perfluoro-methyl-dioxolane-co-PFSA | hybrid glassy | endoskeleton, pillar link |
| | PFMMD-co-PFSA | copolymer | sacrificial filler |
| | PFMDD-co-PFSA | (PFMMD-co-X) | |
| | PFMD-co-PFSA | | |
| | PFMMD-co-PFMD-co-PFSA | | |
| | PFMDD-co-PFMD-co-PFSA | | |
| | +chlorotrifluoroethylene | | |
| | PFMMD-co-CTFE-co-PFSA | | |
| | PFMDD-co-CTFE-co-PFSA | | |
| | +pentafluorostyrene | | |
| | PFMMD-co-PFSt-co-PFSA | | |
| | PFMDD-co-PFSt-co-PFSA | | |
| 19 | poly(dioxo-dihydro-pyrrole-carbonyl) | hybrid glassy | endoskeleton, pillar link |
| | sulfanoyl fluoride-co-styrene (PDDP-CSFS) | copolymer | sacrificial filler |
| | PDDP-CSFS-co-SPmax (sulfo (phenyl | (PDD-co-X) | |
| | sulfonyl)-biphenyl high χ copolymer | | |
| 20 | sulfonated phenyl-alkane (sPh—CₙH₂ₙ₊₂) | hybrid phenyl | endoskeleton, pillar link |
| | phenyl-aldehyde (sPh—CHO) | copolymer | sacrificial filler |
| | | (phenyl-co-X) | |
| 21 | styrene-co-X | hybrid styrene | endoskeleton, pillar link |
| | sulfo poly (trifluorostyrene) linear PTFS | copolymers and | sacrificial filler |
| | cross-link poly (trifluorostyrene) PTFS-X | grafts | cross linker |
| | perfluoroalkoxy alkanes polystyrene | (styrene-co/g-X) | |
| | sulfonic acid PFA-g-PSSA | | |
| | polystyrene co polystyrene-sulfonate | | |
| | copolymer PS-co-sPSS | | |
| | styrene-urethane | | |
| | poly thermoplastic urethane - | | |
| | polystyrene sulfonic acid - divinyl | | |
| | benzene PTPf-PSS-DVB | | |
| | flexible poly thermoplastic urethane | | |
| | ester - rigid poly thermoplastic | | |
| | urethane linear copolymer | | |
| 22 | sulfonated polysulfone P(Sf-sSf) | hybrid polymer | endoskeleton, pillar link |
| | | (sulfone) | sacrificial filler |
| 23 | polyamide sulfonimide P(Am-co-sAm) | hybrid | endoskeleton, pillar link |
| | | copolymer | sacrificial filler |
| | | (polyamide) | |
| 24 | poly sulfonated phosphazene P(Pz-co-sPz) | hybrid polymer | endoskeleton, pillar link |
| | | (phosphazene) | sacrificial filler |
| 25 | poly sulfonated siloxane P(SiX-co-sSiX) | hybrid polymer | endoskeleton, pillar link |
| | | (siloxane) | sacrificial filler |
| 26 | covalent triazine polymers CTP/sCTP | hybrid polymer | endoskeleton, pillar link |
| | sulfonated phenylated CTF-Ph | (triazine) | sacrificial filler |
| | tris(4-formylphenyl)amine sCTP-TPA | | Pd NP catalyst |
| | triazine trifluoride CTP-TF | | |
| | sulfonated triazine framework s6TPh | | |
| | sulfonated triazine framework s3T6Ph | | |
| | fluorinated triazine framework 6T6Ph—F₄ | | |
| | sulfo bi-pyrroles triazine 6T12Ph6bPy | | |
| | sulfonated poly(arylene ether sulfone) | | |
| | triazine bisphenol linear copolymer | | |
| | P(SPAESf)-co-TBPh | | |
| 27 | sulfobutyl-vinylimidazolium-methyl | hybrid methyl | endoskeleton, pillar link |
| | methacrylate copolymer F₃ methane | methacrylate | sacrificial filler |
| | sulfonate (sBVIm-TfO-co-MMA) | copolymers | PMMA nanoclusters |
| | polyester grafted poly(methyl | P(MMA-co-X) | Pd PMMA nanoclusters |
| | methacrylate) (PE-g-PMMA) | | Pd-MMA-MAA bridging |
| | maleic anhydride MAH - poly(methyl | | sulfonated PMMA |
| | methacrylate) linear copolymer | | nanoclusters |
| | P(MMA-co-MAH) | | PMMA porous |
| | maleic anhydride derivative Mi - poly | | nanospheres |
| | (methyl methacrylate) linear copolymer | | ZnS PMMA nanocluster |
| | P(MMA-co-MAH-co-Mi) | | |
| | polyvinylidene fluoride grafted | | |
| | poly(methyl methacrylate) (PMMA-g-PVDC) | | |
| 28 | carboxy methyl cellulose polyvinyl | hybrid polymer | endoskeleton, pillar link |
| | alcohol acrylamide (CMC-PVA-AA) | (carboxy methyl | sacrificial filler |
| | | cellulose) | carboxylated carbon |
| | | | nanotube (CCNT) |
| | | | sulfonated activated |
| | | | carbon (SAC) |
| 29 | multi-acid sidechains (MASC) modifying: | hybrid polymer | endoskeleton, pillar link |
| | PFSA-PTFE CRM | (multi acid | sacrificial filler |
| | PTFE with perfluoro imide acid (PFIA) | sidechain MASC) | |
| | PFSA-PVA-PTFE CRM | | |
| | sulfonated polyarylene ether sulphone | | |
| | (SPAESf, SPAES) | | |
| | sulfonated poly ether-ether ketone | | |
| | (sPEEK) | | |
| | sulfonated poly ether-ether sulfone | | |
| | (sPEESf, sPEES) | | |
| | polyvinyl alcohol (sPVA) | | |
| | phenylene-bibenzimidazole (PBI) | | |
| | chitosan (CS) | | |
| 30 | arylene ether IEM variants | hybrid polymer | endoskeleton, pillar link |
| | sP12F97B | (arylene-ether) | sacrificial filler |
| | sP6F9CB | | |
| 31 | POSS/DSSQ doped hybrid membranes | POSS doped | endoskeleton, pillar link |
| | PFSA-PTFE CRM | hybrid polymers | sacrificial filler |
| | PTFE with perfluoro imide acid (PFIA) | polyhedral | POSS variants |
| | PFSA-PVA-PTFE CRM | oligomeric | POSS-SH, POSS-A-PA, |
| | sulfonated polyarylene ether sulphone | silsesquioxane | POSS-PEG, POSS-iBu, |
| | (SPAESf, SPAES) | (POSS) | POSS-Vi, POSS-BuCl, |
| | sulfonated poly ether-ether ketone | double decker | Ot-POSS, OV-POSS, |
| | (sPEEK) | silsesquioxane | Ph-POSS, POSS-SH, |
| | sulfonated poly ether-ether sulfone | (DDSQ) | POSS-A, POSS-iBu-Vi, |
| | (sPEESf, sPEES) | | POSS-iBu—NH₂, |
| | polyvinyl alcohol (sPVA) | | POSS-iBu—Cl, |
| | phenylene-bibenzimidazole (PBI) | | POSS-iBu—3OH, |
| | chitosan (CS) | | POSS-iBu-styrl |
| | | | POSS-iBu-PS, |
| | | | POSS-R-styrl, POS-R-PS, |
| | | | POSS-Cp-PS, |
| | | | POSS-Cy-PS, |
| | | | POSS-Am-NH₂ |
| | | | POSS-cage & prisms: |
| | | | hexagonal & octagonal |
| | | | pendants, bead, chain, |
| | | | barbells, planar, |
| | | | dendritic, non-planar |
| | | | double decker |
| | | | silsesquioxane: |
| | | | cubic DDSQ, |
| | | | Me/non-Me DDQ |
| 32 | nanoparticle doped/coated hybrid IEMs | hybrid polymer | endoskeleton, pillar link |
| | extend polytetrafluoroethylene ePTFE | nano fillers and | sacrificial filler |
| | PFSA-PTFE CRM | dopants of | polyimide (PI) coating |
| | PTFE with perfluoro imide acid (PFIA) | nanolayers | nanocomposites |
| | PFSA-PVA-PTFE CRM | nanofibers | zirconium composite |
| | sulfonated polyarylene ether sulphone | nanospheres | electrospun nanofibers |
| | (SPAESf, SPAES) | nanotubes | nanoparticle coat CNTs |
| | sulfonated poly ether-ether ketone | | +polybenzimidazole PBI |
| | (sPEEK) | | +pyridine PyPBI |
| | sulfonated poly ether-ether sulfone | | NH₂ CNT |
| | (sPEESf, sPEES) | | Pt—NH₂ NP CNT |
| | polyvinyl alcohol (sPVA) | | Ti—NH₂ NP CNT |
| | phenylene-bibenzimidazole (PBI) | | phosphorated titania |
| | chitosan (CS) | | PO₄TiO₂ CNT |
| | 4-sulfophthalic acid-poly vinyl alcohol | | sGA linker: sulfonated |
| | (SPA-PVA) | | glutaraldehyde |
| | novel nano-doped IEM polymers | | polyethylene oxide PEO |
| | poly(dopamine) (pDA) | | sulfonated polystyrene |
| | poly(sulfonated dopamine) (pSDA) | | nanofibers (sPS) |
| | poly(dopamine-sulfonated dopamine) | | Ag nanoparticles |
| | (p(DA-SDA) | | |
| | polytetrafluoroethylene - titanium (IV) | | |
| | butoxide sol-gel matrix | | |
| 33 | PFSA-PTFE CRM | hybrid polymer | endoskeleton, pillar link |
| | PFSA-PVA-PTFE CRM | with fillers | sacrificial filler |
| | sulfonated polyarylene ether sulphone | (zirconium) | intercalant zirconia iZr |
| | (SPAESf, SPAES) | | intercalant Zr |
| | sulfonated poly ether-ether ketone (sPEEK) | | +OH terminus (α type Zr) |
| | sulfonated poly ether-ether sulfone | | +O terminus (γ type Zr) |
| | (sPEESf, sPEES) | | +X terminus (λ type Zr) |
| | polyvinyl | | X = F⁻, Cl⁻, Br⁻, |
| | alcohol (sPVA) | | OH⁻, HSO₄⁻ |
| | phenylene-bibenzimidazole (PBI) | | zirconium nanosphere |
| | chitosan (CS) | | ZrNS or ZrO₂ |
| | 4-sulfophthalic acid-poly vinyl alcohol | | |
| | (SPA-PVA) | | |
| 34 | grafted IEMs | hybrid polymer | endoskeleton, pillar link |
| | poly(vinylbenzyl chloride)-poly(4,4′- | with metal | sacrificial filler |
| | diphenylether-5,5′-bibenzimidazole)- | organic | metal oxide frame MOF |
| | triazole graft copolymer matrix | frameworks | +guest |
| | (PVBC-co-OPBI-co-OPBI-TG) | (MOF) fillers | +stack/cubic |
| | other MOF-doped IEMs | | +trapezoid |
| | PFSA-PTFE CRM | | +double trapezoid |
| | PTFE with perfluoro imide acid (PFIA) | | +hexagonal drum |
| | PFSA-PVA-PTFE CRM | | +octagonal drum |
| | sulfonated polyarylene ether sulphone | | +rectangular array |
| | (SPAESf, SPAES) | | metal complexes |
| | sulfonated poly ether-ether ketone (sPEEK) | | +Zr₆O₄(OH)₄ |
| | sulfonated poly ether-ether sulfone | | Cr terephthalate cluster |
| | (sPEESf, sPEES) | | sulfonic ferrous cluster |
| | polyvinyl alcohol (sPVA) | | M-L-M configurations |
| | sulfo phenylene- | | M-dithiolene, M-DPPE, |
| | bibenzimidazole (sPBI) | | M-EDT, M-PLTSC, |
| | sulfo chitosan (sCS) | | M-ambidentate, |
| | 4-sulfophthalic acid-poly vinyl alcohol | | M-BIPY, M-Schiff base |
| | (SPA-PVA) | | M-salicylaldehyde |
| | | | metal scavenger MOFs |
| | | | +metal scavenger via |
| | | | metal to hetero-metal |
| | | | ligand (M-L-hM) |
| | | | +ligand scavenger |
| | | | +guest scavenger |
| | | | +interleaved/stacked |
| | | | scavengers |
| | | | +scavenger guests |
| | | | Fe scavenger MOFs |
| | | | Co scavenger MOFs |
| | | | Ni scavenger MOFs |
| | | | zinc-oxide ester |
| | | | hexaphosphate MOF |
| | | | (Zn₆O₂₄(C₆H₁₈O₂₄P₆)) |
| 35 | PWA-doped polysulfone copolymer | hybrid polymer | endoskeleton, pillar link |
| | poly(4-vinylpyridine) (PSf-co-P4VP) | with fillers and | sacrificial filler |
| | +ferro-cyanide- coordinated poly(4- | dopants | molybdenum tungsten |
| | vinylpyridine) (CP4VP) ionomers | (tungsten) | nanoparticles (Mo—W NPs) |
| | PWA-doped poly vinyl alcohol with | | phosphotungstic acid |
| | quaternized polyethyleneimine | | silica clusters (SiO₂-PWA) |
| | copolymer (PVA-co-QPEI) | | |
| | +chlorophenyl)methyl-dihydro | | |
| | benzodioxin-methyloxidanylidene- | | |
| | benzothiazine-carboxamide (R₄N⁺) | | |
| | ionomers | | |
| | other PWA-doped IEMs | | |
| | PFSA-PTFE CRM | | |
| | PTFE with perfluoro imide acid (PFIA) | | |
| | PFSA-PVA-PTFE CRM | | |
| | sulfonated polyarylene ether sulphone | | |
| | (SPAESf, SPAES) | | |
| | sulfonated poly ether-ether ketone (sPEEK) | | |
| | sulfonated poly ether-ether sulfone | | |
| | (sPEESf, sPEES) | | |
| | polyvinyl alcohol (sPVA) | | |
| | sulfo phenylene-bibenzimidazole (sPBI) | | |
| | sulfo chitosan (sCS) | | |
| 36 | zeolite doped IEMs | hybrid polymer | endoskeleton, pillar link |
| | PFSA-PTFE CRM | with fillers | sacrificial filler |
| | PTFE with perfluoro imide acid (PFIA) | (zeolite) | phenylated zeolite |
| | PFSA-PVA-PTFE CRM | | sulfonated mordenite |
| | sulfonated polyarylene ether sulphone | | sulfonated zeolite |
| | (SPAESf, SPAES) | | frameworks |
| | sulfonated poly ether-ether ketone | | zeolite nanoparticles |
| | (sPEEK) | | |
| | sulfonated poly ether-ether sulfone | | |
| | (sPEESf, sPEES) | | |
| | polyvinyl alcohol (sPVA) | | |
| | sulfo phenylene-bibenzimidazole (sPBI) | | |
| | sulfo chitosan (sCS) | | |
| 37 | polysulfone IEMs | acid-base | endoskeleton, pillar link |
| | sulfonated polysulfone (sPSf, sPSU) | polymers and | sacrificial filler |
| | bromated polysulfone (BrPSf, BrPSU) | fillers | functionalized |
| | para-linked bromated polysulfone | (polysulfone) | graphene oxide |
| | (BrPSf)ₓ or (BrPSU)ₓ | | sulfonated polysulfone |
| | polysulfone filler doped IEMs | | (FPGO-sPSf, FPGO-sPSU) |
| | PFSA-PTFE CRM | | platinum titanium |
| | PTFE with perfluoro imide acid (PFIA) | | titanium dioxide |
| | PFSA-PVA-PTFE CRM | | nanoparticle |
| | sulfonated polyarylene ether sulphone | | (Pt—TiO₂ NPs) |
| | (SPAESf, SPAES) | | polyoctahedral |
| | sulfonated poly ether-ether ketone | | silsesquioxanes (POSS) |
| | (sPEEK) | | |
| | sulfonated poly ether-ether sulfone | | |
| | (sPEESf, sPEES) | | |
| | polyvinyl alcohol (sPVA) | | |
| | sulfo phenylene-bibenzimidazole (sPBI) | | |
| | sulfo chitosan (sCS) | | |
| 38 | PBI/OPBI anhydrous IEMs | anhydrous | endoskeleton, pillar link |
| | poly phenylene-bibenzimidazole (p-PBI, | polymers and | sacrificial filler |
| | m-PBI) | copolymers | pristine electrospun |
| | poly oxydiphenylene-bibenzimidazole | (PBI) | PBI/OPBI nanofibers |
| | (OPBI) | | crushed electrospun |
| | +hexyl-vinylimidazolium dihydrogen | | PBI/OPBI nanofibers |
| | phosphate proton ion liquid | | hexachlorocyclo- |
| | (PHVIm-H₂PO₄) PIL | | triphosphazene (HCCP) |
| | poly dihydroxy phenylene (2OH-PBI) | | imidazolechlorocyclo- |
| | hexafluoroisopropylidene- | | triphosphazene (ImCCP) |
| | polybenzimidazole (F₆-PBI) | | PBI-ZIF phenylene |
| | sulfur dioxide polybenzimidazole | | benzimidazole - zeolitic |
| | (SO₂-PBI) | | imidazolate framework |
| | poly(arylene ether benzimidazole) | | |
| | (PAEBI) | | |
| | poly(2,5-benzimidazole) (ABPBI) | | |
| | cross linked PBI chains | | |
| | oxydiphenylene benzimidazole - | | |
| | poly(vinylbenzyl chloride) | | |
| | copolymer (OBPI-co-PVBC) | | |
| | +quaternary ammonia linked (DABCO, | | |
| | quinuclidine, quinuclidinol) | | |
| | +phosphoric acid (PA) doped | | |
| | oxydiphenylene benzimidazole - | | |
| | polyaniline copolymer (OPBI-PANI) | | |
| | +quaternary ammonia linked | | |
| 39 | chitosan (CS) biopolymer IEMs | biopolymers & | endoskeleton, pillar link |
| | chitosan poly(D-glucosamine) | copolymers | sacrificial filler |
| | chitosan poly(N-acetyl-D-glucosamine) | chitosan | P[HVIm] H₂PO₄ PIL |
| | sulfonated chitosan (sCS) | cellulose | functionalized CNT |
| | cross linked sulfonated chitosan (XL-sCS) | alginic acid | |
| | chitosan sulfonate (sCS) | | |
| | phosphorylated chitosan (pCS) | | |
| | functionalized CS bio-copolymer IEMs | | |
| | CS-co-polyacrylonitrile f(CS-co-PAN) | | |
| | CS-co-polystyrene f(CS-co-PS) | | |
| | CS-co-polyvinyl alcohol f(CS-co-PVA) | | |
| | CS-perfluorinated sulfonic acid (CS-PFSA) | | |
| | vinylpyridine CS graft (CS-g-PVP) | | |
| | +carbon nanotube (CS-g-PVP-CNT) | | |
| | styrenesulfonic acid CS graft (CS-g-SSA) | | |
| | +carbon nanotube (CS-g-PVP-SSA) | | |
| | POSS crosslinked chitosan (POSS XL CS) | | |

### § 1. PFSA Homopolymer IEMs.

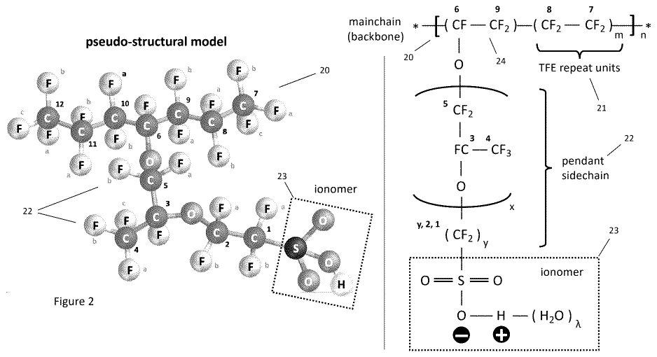

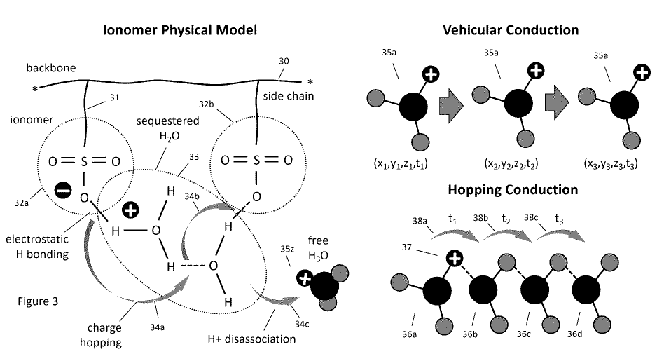

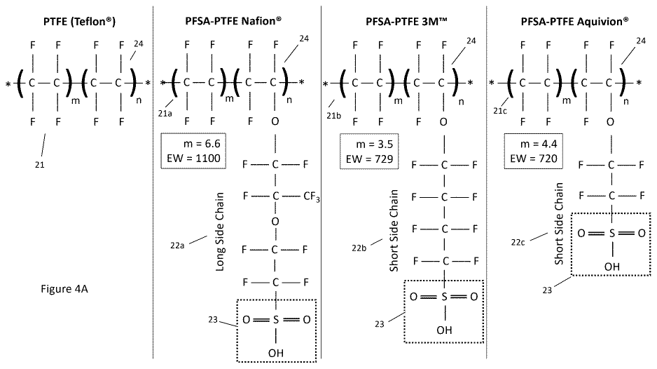

As detailed previously homogeneous films of perfluorosulfonic acid having the acronym PFSA comprise the combination of a structural fluorocarbon backbone with sidechains bridging mainchain carbon atoms to sulfonic acid ionomers through intervening sidechains. Together the combination of the electrically active PFSA ionomer and its associated sidechain form a pendant, so named because it “hangs off” of the mainchain. As depicted previously in FIG. 2, the pendant frequency occurs at a semiregular repeating interval, which determines the conductivity of the film. The sidechain length and composition also vary in length depending on the monomer used in the fabrication process.

In homogeneous PFSA membranes the mechanical strength of the film is determined purely by its backbone while the sidechain length affects the film density and water transport. Without the sidechain the hydrophilic sulfonic acid would be unable to bond to the hydrophobic backbone. Pure PFSA films are however notoriously fragile and subject to swelling during operation. As one embodiment made in accordance with this invention, a homogenous membrane of PFSA is mechanically strengthened by am endoskeletal framework of stronger more-rigid polymers to which the PFSA attaches. The resulting structure reduces excess moisture retention and swelling of the film while improving handling. In another embodiment of the invention, the PFSA microporosity is controlled by inclusion of a sacrificial filler introduced during the dispersion casting and polymerization process.

Strictly defined, the backbone of pure PFSA can be categorized as the hydrophobic polymer polytetrafluoroethylene or PTFE which connects to the hydrophilic sulfonic acid ionomers through varying length sidechains, together able to function as a cation specific conduction medium. Pragmatically however, the term PTFE is generally used in reference to a non-conductive homopolymer, not to a blend of PFSA and PTFE. Instead PFSA-PTFE blends are heterogenous, and herein are referred to as a composite reinforced membrane or CRM.

The below table and similar tables to follow throughout the application describes the general structural category of the film, the mechanical structural support of the film, solvents and reagents used for mixing or delivering monomers and solutes, solvents and reagents used for promoting cross linking (denoted in the table by the abbreviation X-L), and various skeletal support options made in accordance with this invention.

The following table lists various attributes of a bulk PFSA homopolymer:

| ionomer | structure | endoskeleton | solvents, X-L | fillers |
|---|---|---|---|---|
| §1. perfluorinated | PFSA | polymer: PTFE, FEP, | solv: PVA, PFOA, | sac filler, CNTs, |
| sulfonic acid | homopolymer | PE, PP. | HFC, polyethylene | oxides, POSS, |
| bulk PFSA | | pillars: reinforced | X-L: P(AA-AMPS) | NPs, MOFs, PIL |
| | | fillers (C-fiber/NT) | | |

Nascent perfluorinated sulfonic acid, referred to as bulk PFSA is an ionomeric polymer comprising a hydrophobic mainchain with a perfluorinated sidechain pendant and a sulfonic acid ionomer as the sidechain terminus. Despite comprising a mainly tetrafluoroethylene (TFE) backbone blended with modified segment substituting the mainchain fluorine for an oxygen linked sidechain, pristine PFSA is considered a homopolymer. The copolymer of PFSA and PTFE, containing longer segments of poly tetrafluoroethylene (PTFE) mixed with PFSA sidechains is referred to as a hybrid composite reinforced membrane or CRM is discussed separately in section 2. The adjective ‘bulk’ refers to the conduction mechanism, mainly that the conductive channels for ion transport in pure PFSA are bulk properties, not limited by surface conduction along the polymer's inner surfaces.

As previously articulated, one of the innovative features of the described cationic IEM or PEM is the integration of a chemically inert endoskeleton into the ionomeric membrane, providing both mechanical support and suppressing film swelling and contraction. Bonding between the PFSA and an inert endoskeleton depends on the compatibility of hydrophilic and hydrophobic components or upon bridging between the two. In fact, because of the inert nature of PTFE it remains challenging to bond it to anything. The best way to form PTFE bonded to PFSA is by co-molding them concurrently. Because the backbone of PFSA is tetrafluoroethylene, identical is composition but shorter in length than PTFE, the two spines are compatible and interchangeable.

Aside from polytetrafluoroethylene (PTFE), endoskeleton candidates able to bond to pure PFSA ionomeric films include fluorinated ethylene propylene (FEP), polyvinylidene fluoride (PVDF). Otherwise bonding to PTFE requires a cross linking adhesive such as PVA or a fluoropolymer-based glue. Endoskeletal candidates include polymers with low-energy surfaces such as polyethylene (PE) and polypropylene (PP).

Solvents used in the preparation of PFSA polymers involve poly vinyl alcohol (PVA); carcinogenic perfluorooctanoic (PFOA); hydrofluorocarbon (HFC) compounds comprising hydrogen, fluorine, and carbon; polyethylene (PE); and P(AA-AMPS), a copolymer of poly acrylic acid (AA) and 2-acrylamido-2-methyl-1-propane sulfonic acid (AMPS).

In various embodiments made in accordance with this invention, various fillers and dopants added to bulk PFSA films may include sacrificial fillers and permanent fillers. Sacrificial fillers may a comprise sugar on dissolvable solid whose solvent does not damage the polymer matrix during filler removal. Permanent fillers include (a) carbon fillers, (b) oxide fillers, (c) POSS fillers, (c) nanostructure fillers, (d) MOFs, and (e) solid acid fillers, ionic liquids, and PIL dopants. Among these, carbon fillers include functionalized nanotubes (CNTs), functionalized graphene oxide (GO), and functionalized carbon nanotubes (CNTs).

Oxide fillers include silica, zeolites, mordenite, nesosilicates, silica mesostructured cellular foam (Si-MCF), and hollow mesoporous silica (HMS). Metal oxides include molybdate, Al-grafted mesoporous silica (MCF-ionomer), zirconium-dopamine composites, intercalant zirconium. and phosphotungstic treated silica. Polyhedral and double decker oligomeric silsesquioxanes (POSS, DDSQ) include countless chemical and structural variants. Nanostructure fillers include metallic and ionic nanoparticles, nanospheres, nanoclusters, and nanofibers. MOFs include catalytic, ionomeric, and scavenger metals in various geometries. Solid acids, ionic liquids and PILs comprise additives used to control conductivity through film pH.

### § 2. PFSA-PTFE Heteropolymer & CRM IEMs.

As described, a heterogenous |EM polymeric film comprising a blend of a PFSA monomer with a mechanical support polymer such as PTFE, PFMMD, PDD, styrenesulfonate, polyethylene, polystyrene, ketone nitrile, polyphenylene, poly-arylene, polyamide, poly-ketone (PEEK), and other carbon or hydrocarbon compounds. Such heterogenous films are referred to as a composite reinforced membranes or CRM in recognition that the backbone, generally hydrophobic, provides mechanical support. Compared to pure bulk conducting perfluorinated sulfonic-acid (PFSA), however, many composite reinforced membranes (CRMs) achieve stability only by sacrificing ionomeric density resulting in lower current densities and reduced conductivities.

In accordance with the Grotthuss mechanism of hopping conduction between protons and water molecules, high proton conductivities result mainly from protons, i.e. ionized hydrogen, released from sulfonic acid groups able to hop along the ionomers aided by local vehicular water molecules. Only by either increasing microporosity to enhance water membrane permeability or by increasing the densities of ionomeric pendants can proton transport be improved. Accordingly the greater the microporosity or the higher the density of sulfonic acid groups in the membrane, the higher the density of hydronium ions transporting ionic charge, and the greater the net proton conductivity. Because, however sulfonic acid is hydrophilic and TFE is not, forming a secure bond to a hydrophobic backbone like PTFE subsequent to PFSA polymerization requires a solvent or glue such as PVA for intermolecular bonding. As such, a heteropolymer IEM comprising a PVA-bonded coating of PFSA atop a hydrophobic TFE-PTFE mainchain is referred to in the above table as a PFSA-PVA-PTFE composite reinforced membrane. It should be understood that in a porous membrane filled with nooks and crannies like Swiss cheese, the term ‘surface’ has two different meanings which in some discussion may be ambiguous.

In its macrostructural context, the surface of the membrane is the two dimensional atomic plane forming an interface with the catalyst layer comprising the CCM, i.e. the catalyst coated membrane. In a microstructural context, the inner walls of any chamber, pore, conduit, tube, or channel present within the polymer matrix represents a microscopic surface along which surface current can flow. So while the macrostructural surface of the IEM is perpendicular to the fuel cell's current flow, conduction within the membrane is parallel to the microporous surfaces and orthogonal to the macrostructural surface.

For this reason, hybrid PFSA-PTFE CRM membranes may be considered as surface conductors rather than bulk conductors because the hydrophobicity of PTFE limits internal hydration suppressing bulk vehicular transport of hydronium ions within the pores instead relegating cation conduction to charge hopping from ionomer-to-ionomer occurring along the exposed inner surfaces of the pores. To enhance the conductance of a CRM, the density of micropores must be increased to maximize the films internal surface area thereby exposing more sulfonic acid ionomeric groups to contribute in charge transport, analogous to enhancing the surface area of activated charcoal in a filter. Alternatively, additional protons can be added using membrane doping by ionic liquids.

By contrast, significantly increasing the size rather than the density of pores within an ionomer suffers from numerous drawbacks. Although larger pores enhance film hydration enhancing vehicular transport of hydronium ions, the larger pores increase the preponderance of fuel crossover and oxygen back streaming. When pores become too large the incoming hydrogen fuel source entering the anode comprising either hydrogen gas in a H₂ fuel cell or methanol in a direct methanol fuel cell (DMFC) is able to transit unimpeded from the anode into the cathode without first being ionized into protons. Significant fuel crossover in large pore membranes is problematic for a variety of reasons. This means porosity is a key factor is determining IEM performance and limiting fuel crossover.

Firstly, un-ionized hydrogen crossover wastes fuel. Hydrogen gas passing unimpeded from anode to cathode is released into the atmosphere unused as a gaseous effluent without enhancing fuel cell electrical conduction or generating electricity. Secondly, if the hydrogen gas content in the oxygen rich cathode exceeds a certain concentration, a flammable gaseous mix of H₂ and O₂ may result in the cathode. Thirdly, hydrogen reacting with oxygen in the cathode can produce hydrogen peroxide (H₂O₂) that diffuses into the ionomeric membrane. The hydrogen peroxide bonds to the sulfonic acid groups inhibiting their proton exchange ability and permanently degrading the ionomer and fuel cell operation. In this scenario ionomer damage is likely non-uniform with the greatest impairment of ionomer function located nearer the cathode. As such, transport through the damage zone relies exclusively on vehicular transport with greatly diminished charge hopping conduction. The net result is lower fuel cell current, higher voltage sag, lower film conductance, reduced energy efficiency, and greater heat dissipation.

The formation of overly large pores in the membrane can also encourage oxygen back streaming. the process whereby unreacted oxygen gas flows from the cathode across the membrane into the anode. Once there, the oxygen invariably reacts with the hydrogen rich atmosphere producing hydrogen peroxide (H₂O₂). The anodically generated H₂O₂ then diffuses into ion exchange membrane bonding to sulfonic acid ionomer groups degrading the fuel cell performance in a manner similar to the effect of cathodic hydrogen peroxide except that the damage zone, the region of greatest functional impairment, is closest to the anode rather than the cathode.

Another adverse effect of a membrane with excessive large pores is diminished mechanical strength. Like osteoporosis in living bone, an overly porous membrane becomes brittle and easily damaged from stresses incurred during manufacturing and handling. Moreover, large pores easily retain excess water causing the membrane to swell excessively during operation in humid ambient conditions, especially at high current densities. Conversely, during inactivity membrane stored water easily drains from large pores causing drying and film contraction. Humidity cycling during operation repeatedly causing swelling and drying stresses the film eventually precipitating microcracks in the membrane which grow in length and size until the membrane leaks gas and can no longer operate reliably or safely.

To avoid these various failure modes, a heterogenous ion exchange membrane made in accordance with this invention includes some combination of (i) micropores and nanopores fabricated with consistent dimensions and densities, (ii) strengthened endoskeletal support to limit film stresses from handling and humidity cycling, and (iii) a nanocoating to prevent carbon monoxide and other gaseous toxins from invading the cathode and damaging the catalyst coated membrane (CCM) core of the fuel cell. These preventative measures may include molecular blockers, metal scavengers, and antidotes to unwanted chemical toxins. These protective measures may be incorporated into the ionomeric membrane matrix, into the catalyst layers, and optionally into the gas diffusion layer. Protection against environmental contaminants need only be into the cathode side of an MEA5 as the cathode air exchange is exposed to the unfiltered ambient while the anode gasses are self-contained and thereby protected from contamination.

Membrane top view 3000 and membrane side view 3001 in FIG. 107 illustrate a variety of elements of ionomeric polymer 3002 comprising a composite reinforced membrane (CRM) of PFSA-PTFE made in accordance with this invention, including separately or in combination inventive matter comprising:
an ion exchange membrane 3003 composed of one or more polymeric chains 3009c including ionomers 3009i present along the backbone or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the introduction of a sacrificial filler prior to molding and its subsequent removal post-casting by a solvent leaving a hole or ‘pore’ in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise perfluorinated sulfonic acid (PFSA) 24 linearly bound to fluoropolymer polytetrafluoroethylene (PTFE) 21 to form a heterogenous composite reinforced membrane of PFSA-PTFE; copolymerized with polyvinyl alcohol (PVA) to form a heteropolymer of PFSA-PVA-PTFE able to bond to other materials including endoskeletal pillars; or where the PFSA-PTFE composite is blended with other homopolymers, heteropolymers, or copolymers forming the mainchain and controlling crystallinity and fuel crossover in the matrix. Alternatively the PFSA 24 chain may comprise a separate chain cross linked to a separate PTFE chain 21 (not shown).
where ionomeric polymer 3002 may include sidechains or pendants 22 whose length and composition control crystalline regularity, and influencing porosity, conductivity, and fuel crossover of the membrane;
where ionomeric polymer 3002 may comprise an ionomer 3009i of reactive sulfonic acid groups —SO₃H 23, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

In an alternative embodiment of the invention the structural membrane is coated with a colloidal dispersion of solvent and PFSA, i.e. where nanoscopic particles of PFSA are suspended in the solvent forming small primary aggregates of three-to-four molecules as dictated by the polar solvent chemistry. During curing, these clusters then agglomerate into secondary aggregates on the order of hundreds of nanometers in size forming rodlike structures 1 nm in diameter depending on the ratio of water to alcohol in the solvent. The dispersion also naturally forms chemical bonds to the semi-rigid endoskeleton made in accordance with this invention as described previously for FIG. 106, especially when treated with PVA. The resulting membrane is identified in the forgoing table as “PFSA-PTFE dispersed nanoparticles”.

In another embodiment made in accordance with this invention, membrane conductivity is improved by increasing porosity using a process involving the introduction and subsequent removal of a sacrificial filler as part of the membrane fabrication sequence resulting in vacancies in the polymeric matrix appearing as empty bubbles referred to herein as sacrificial pores 3005. Like the endoskeletal support frame, the sacrificial filler process is equally applicable to heterogenous CRM membranes formed using either a PFSA-PVA-PTFE process and structure, a dispersion of PFSA-PTFE nanoparticles, or a combination thereof.

As copolymers of PFSA and PTFE, these hybrid films including PFSA-PTFE and PFSA-PVA-PTFE ionomeric polymers comprise composite reinforced membrane or CRMs providing mechanical resilience and durability advantages over PFSA. Because however, PTFE is a dense semi-crystalline electrically insulating and hydrophobic polymer, its incorporation into a PFSA polymer invariably reduces membrane conductivity by suppressing vehicular transport of hydronium through bulk channels. Instead electrical conduction is limited to proton transport via charge hopping along the PFSA backbones, comprising the so-called Grotthuss mechanism. Since the conduction throughout the matrix occurs through ionomer termini of sulfonic acids arranged linearly along PFSA chains, the cross sectional area of charge transport channels is reduced by the presence of excess PTFE either as separate chains or as PFSA with extended portions of PTFE 21 in the mainchain, i.e. where m>>n. Mechanistically, the impact of the preponderance of PTFE groups in the matrix is charge transport behavior similar to surface conduction, consequentially resulting in a more resistive film.

To compensate for a decreased conductance, the hybrid film must be thinned to 20 μm or less relying on the mechanical strength of PTFE to prevent film breakage during handling. Made in accordance with this invention, the introduction of a reinforcing endoskeleton into the membrane provides added mechanical support for handling of the film, thereby allowing the mole fraction of PTFE in the blend to be reduced. By reducing the fraction of PTFE in the polymer, conductance is enhanced by a higher density of PFSA chains and through greater porosity. The number of conductive pores is further enhanced by the introduction of a sacrificial filler such as sucrose into the polymer prior to casting and subsequently removing it to form micropores.

The micropores are able to transport protons, water and hydronium ions. Hydrogen atoms, oxygen atoms, hydronium ions, and water molecules have effective diameters of 0.08 nm, 0.13 nm, 0.2 nm, and 0.28 nm respectively, meaning all four masses should be able to pass through any pore 0.3 nm in diameter. In a hydrogen fuel cell oxygen back-streaming from the anode to the cathode to the anode is minimal, not because of pore size but because of a small yet perpetual positive pressure differential between the anode and cathode maintained by the hydrogen gas supply. accordingly hydrogen gas flow occurs primarily from anode to cathode attached to larger water molecules, forcing oxygen to swim upstream against a prevailing current. As such, a reasonable density of micropores can be introduced into the PEM membrane to enhance conductivity without significantly increasing oxygen back-streaming, i.e. crossover.

In the case of a DMFC, the maximum pore size is limited by the need to prevent fuel crossover, the unwanted flow of methanol across the membrane. Methanol is a relatively large molecule having an average diameter of 0.36 nm, nearly double that of an hydronium ion. Because of its larger molecular dimension, channels in the membrane with dimensions greater than 0.2 nm but less than 0.35 nm will transport protons but prevent methanol cross-over.

As such, the introduction of sacrificial fillers into the mold casting process forms conductive channels in the polymeric matrix facilitating the ability to adjust conductance of a membrane independent of its thickness. One such sacrificial filler made in accordance with this invention is sucrose or alternatively fructose or glucose. Sugars comprise rather large molecules compared to elemental atoms, but are diminutive contrasted to hydrocarbon fuels and large polypeptides such as proteins. Specifically, sucrose has an average cross sectional dimension of 0.7 nm to 0.9 nm. In the sacrificial filler process described herein, dissolved sucrose leaves empty regions called vacancies or sac pores in the polymer matrix. These vacancies appearing as holes or bubbles in the polymer roughly equal to the molecular dimensions of the sacrificial filler used to create them.

While these vacuous bubbles may appear overly large compared to oxygen and methanol, in reality sacrificial sucrose does not form contiguous pores of the same size as its vacancy bubbles. Instead, at low sucrose concentrations the bubbles do not overlap but connect through smaller channels in the polymer matrix, analogous to the small openings in a spider web. These narrow conduits serve as choke points limiting gas flow. Being a semi-amorphous semi-crystalline polymer, it is impossible to predict a-priori the actual size and density of gas channels created in a PFSA-PTFE CRM by a sacrificial filler process. Instead, an optimum degree of porosity can be determined empirically by adjusting the quantity of filler mixed with the polymer for casting and measuring the tradeoff between conductivity and undesirable back-streaming or adverse fuel crossover effects. Alternatively, if film porosity is too great, a smaller sacrificial sugar such as fructose or glucose may be used in place of sucrose.

Aside from the important role of sacrificial fillers in PEM fabrication as described in various embodiments made in accordance with this invention, permanent fillers and dopants added to the matrix can further enhance mechanical and electrical film properties. A permanent filler is a foreign material not a monomer of the chain which once introduced and molded into the polymer remains indefinitely as part of the polymeric matrix. Permanent fillers include (a) carbon fillers, (b) oxide fillers, (c) POSS fillers, (c) nanostructure fillers, (d) MOFs, and (e) solid acid fillers & PIL dopants.

Among these, carbon fillers include functionalized nanotubes (CNTs), functionalized graphene oxide (GO), and functionalized carbon nanotubes (CNTs). Oxide fillers include silica, zeolites, mordenite, nesosilicates, silica mesostructured cellular foam (Si-MCF), and hollow mesoporous silica (HMS). Metal oxides include molybdate, Al-grafted mesoporous silica (MCF-ionomers), zirconium-dopamine composites, intercalant zirconium. and phosphotungstic treated silica. Polyhedral and double decker oligomeric silsesquioxanes (POSS, DDSQ) include countless chemical and structural variants. Nanostructure fillers include metallic and ionic nanoparticles, nanospheres, nanoclusters, and nanofibers and may include ionic or metallic functional groups. MOFs include catalytic, ionomeric, and scavenger metals in various geometries, where homogeneous and heterogenous elemental metal atoms and metallic clusters are suspended in a matrix or organic ligands. Solid acids and PILs comprise additives used to control conductivity through film pH. The discussion of fillers and dopants, while mentioned here specifically in the context of a PFSA-PTFE film, the concept is general and applies equally for all membrane types.

The composition of PFSA-PTFE composite reinforced membranes including its ionomer type, heteropolymeric backbone structure, solvents used in its synthesis, composition of its inventive endoskeleton, and novel use of fillers and dopants is listed in the table below. Structurally, the attachment of a PFSA-PTFE film to a support endoskeleton is neither trivial nor obvious, particularly if the pillars forming the endoskeleton are also made of a hydrophobic PTFE matrix.

| ionomer | structure | endoskeleton | solvents, X-L | fillers |
|---|---|---|---|---|
| §2. perfluorinated sulfonic | PFSA CRM | polymers: PTFE, | solv: PVA, PFOA, | sac filler, CNTs, |
| acid poly tetrafluoro | heteropolymers | FEP, PE, PP | HFC, ethanol, PE | oxides, POSS, |
| ethylene | | pillars; reinforced | X-L: P(AA-AMPS), | NPs, MOFs, PIL |
| PFSA-PTFE | | fillers (C-fiber/NT) | TFE, GA | |
| PFSA-PVA-PTFE | | | | |

Solutions to this bonding problem include (a) co-molding the membrane and the pillars at the same time where separate mold chambers containing different mold materials cross link during polymerization possibly aided by a cross-linking agent like glutaraldehyde (GA) or tetrafluoroethylene (TFE), (b) damage the endoskeletal pillars with a chemical etch or radiation to create bonding sites for the membrane to attach to, (c) form bondable groups on the pillars so that the membrane can attach itself, (d) coat the pillars with an adhesive that can glue to the membrane, or (e) form a copolymer membrane where one of the polymer groups readily attaches to the pillar. This process and the resulting connection between the endoskeletal pillar and the membrane is referred to herein as a pillar link. Although the pillar link is most challenging when hydrophobic polymers such as PTFE are involved, the methods described are applicable to any combination of endoskeletal and ionomeric membrane material and will not be repeated again for each section.

### § 3. Amorphous Glassy Matrix Homopolymer IEMs.

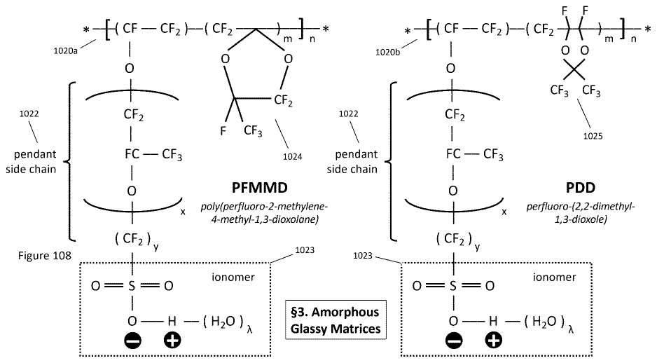

In an alternative embodiment, the inert molecular backbone of a composite reinforced membrane is modified using an alternative homopolymer chemistry having a lower atomic density than PTFE. An example of this approach is illustrated in FIG. 108 where the PTFE hydrophobic mainchain is chemically modified into a more porous compound PFMMD 1020a or PDD 1020b without disturbing pendant sidechain 1022 or sulfonic ionomer 1023. Such molecules form amorphous structures exhibiting lower-densities than the more crystalline-like PTFE polymer. Various methods may be used to form an amorphous glassy matrix ion exchange membrane.

In an exemplary PFMMD 1020a structure as depicted. one of the CF₂ bonds in the m-repeat group of PFSA is replaced by a fluorinated carbon-oxygen ring 1024 to form a perfluoro-(2-methylene-4-methyl-1,3-dioxolane) membrane having the acronym PFMMD. The structural change impacts both bulk and interfacial membrane permeabilities affecting oxygen solubility, diffusivity, interfacial permeation rate constants, and ionomer distribution in the catalyst layer. While the increased permeability may weaken CRM strength, when used in conjunction with the semi-rigid endoskeletal frame made in accordance with this invention, film porosity as determined by the m-to-n ratio of the polymeric repeated units for PFMMD can be optimized without concern for affecting membrane mechanical properties such as strength, durability, and swelling.

In an alternative implementation PDD 1020b one of the CF₂ bonds in the m-repeat group of PFSA is replaced by a cross-linked oxygenated fluorocarbon attached to trifluoromethyl groups to form a ring-structured monomer 1023, perfluoro-(2,2-dimethyl-1,3-dioxole) also know as PDD. By enhancing membrane permeability, oxygen transport resistance is reduced enhancing PEM conductivity. Another benefit of the enhanced permeability is an increase in interfacial catalytic activity and suppression of layered backbone folding of the ionomer near the catalyst surface.

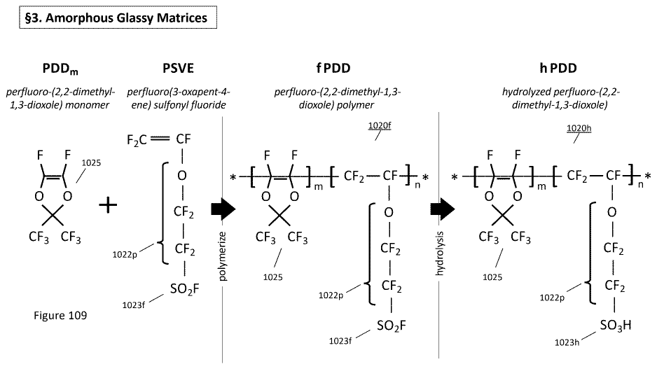

Fabrication of glassy amorphous films involves a two-step process—polymerization and hydrolysis. FIG. 109 describes the process flow for forming amorphous glassy matrix membranes from starting materials PDDₘ and PSVE, followed by polymerization, and subsequent hydrolysis. The exemplary process flow describes forming PDD starting with the PDD monomer precursor 1025 comprising perfluoro(2,2-dimethyl-1,3-dioxole) mixed with PSVE perfluoro(3-oxapent-4-ene) sulfonyl fluoride containing pendant 1022p and a fluorinated sulfonic group 1023f comprising SO₂F.

Like PFSA-PTFE, polymerization of glassy matrices ensues by slowly stirring the components in an inert atmosphere with a polymerization initiator [CF₃(CF₂)₂ C(═O)O—]₂ for example available from Tokyo Chemical Industry Co., Ltd dissolved in Vertrel™ XF solvent available from DuPont-Mitsui Fluorochemicals Co., Ltd for three days. Vertrel™ XF is a proprietary hydrofluorocarbon (HFC) fluid designed to replace current hydrochlorofluorocarbon (HCFC) and perfluorocarbon (PFC) fluids and well suited for use in vapor degreasing equipment for cleaning, rinsing, and drying.

The polymer is then heated to 100° C. to remove fluid. Hydrolysis is performed by immersing the film in NaOH aqueous solution and heating to 130° C. for 12 hours, followed by rinsing in HCl and deionized water at 80° C., thereby converting fluorinated side group 1023f into a hydrolyzed terminus 1023h to realize sulfonic ionomer 1023. Through hydrolysis, the polymer perfluoro-(2,2-dimethyl-1,3-dioxole) (fPDD) 1020f is thereby converted into hydrolyzed perfluoro-(2,2-dimethyl-1,3-dioxole) (hPDD) 1020h.

Although these membranes hold promise in fuel cell, electrolysis, and filter applications they are inherently glassy and brittle requiring added mechanical support especially during manufacturing and MEA7 assembly. As such, membrane integrity can be greatly enhanced through integration with the endoskeletal and exoskeletal support and frame.

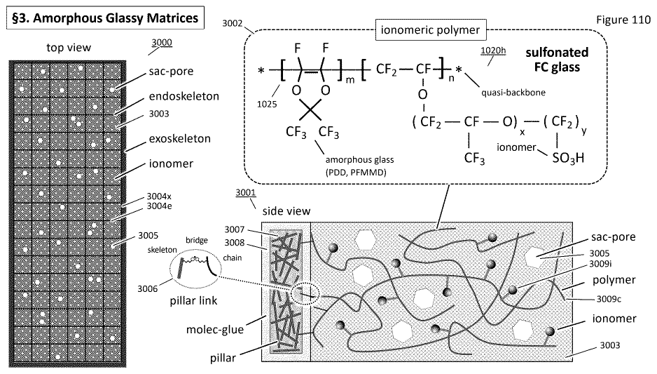

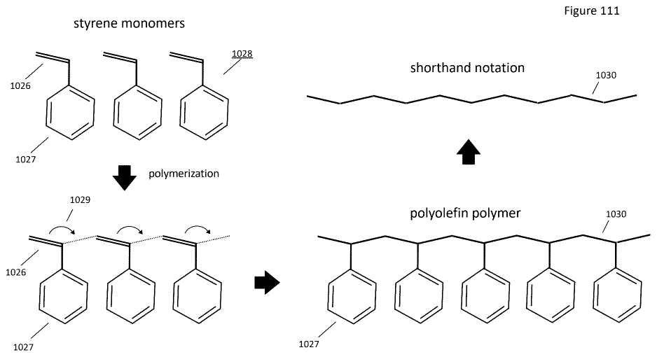

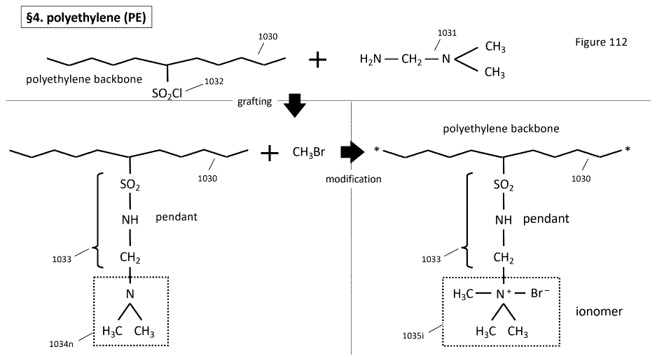

In summary, membrane top view 3000 and membrane side view 3001 in FIG. 110 illustrate a variety of elements of amorphous glassy ionomeric polymers 3002 made in accordance with this invention, including separately or in combination inventive matter comprising
an ion exchange membrane 3003 composed of one or more polymeric chains 3009c including ionomers 3009i present along the backbone or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the introduction of a sacrificial filler prior to molding and its subsequent removal post-casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise a sulfonated amorphous material or glassy matrix such as hydrolyzed perfluoro-(2,2-dimethyl-1,3-dioxole) aka PDD 1020h comprising a fluorocarbon or other homopolymers, heteropolymers, copolymers, or blends forming the mainchain and controlling crystallinity and fuel crossover in the matrix;
where ionomeric polymer 3002 may include sidechains or pendants such as trifluoromethyl radical in perfluoro-(2,2-dimethyl-1,3-dioxole) aka PDDₘ 1025ₘ or poly(perfluoro-2-methylene-4-methyl-1,3-dioxolane) aka PFMMD disrupting crystalline regularity, and influencing porosity, conductivity, and fuel crossover of the membrane; where a PFMMD can form a copolymer with PFSA;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR₄⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

A summary of fabrication conditions for glassy IEMs is described in the table below.

| ionomer | structure | endoskeleton | solvents, X-L | fillers |
|---|---|---|---|---|
| §3. glassy amorphous | amorphous | polymer: PFMMD, | solv: DMF, HFB, | sac filler, CNTs, |
| matrix | glassy CRMs & | PMMA, PU, PVDF. | DEC | oxides, POSS, |
| PDD | homopolymers | pillars: reinforcing | X-L: FBzO, FDTBO, | NPs, MOFs, PIL |
| PFMMD | | fillers (C-fiber, CNTs) | PFDMO | |

As described, a glassy amorphous IEM comprises a composite reinforced membrane comprising PDD, PFMMD, or any other homopolymer having large groups that interfere with polymer crystallinity. Although any number of endoskeletal materials may be used in pillar construction, molecules of similar composition to the membrane such as PFMMD, PMMA, PU, and PVDF offer better bonding strength then hydrophobic perfluorinated materials. Exemplary solvents include dimethylformamide (DMF), hexafluorobenzene (HFB, F₆Bz), and diethyl carbonate (DEC). During synthesis, cross linking agents include perfluorodibenzoyl peroxide (FBzO)₂ or simply FBzO, perfluoro-di-tert-butyl peroxide (FDTBO), and perfluoro-dimethyl-dioxolane (PFDMO). Membranes fillers and dopants were described previously and for brevity's sake, will not be repeated here.

Applications of glassy amorphous membranes include gas separation membranes and proton exchange membranes for hydrogen fuel cells.

### § 4. Functionalized Polyethylene (PE) Polymer IEMs.

As an alternative to a composite reinforced membrane comprising a fluorocarbon backbone such as PTFE, enhanced mechanical stability can also be achieved using a fluorine-free membrane comprised of hydrocarbon homopolymers known as a polyolefins. One example of a polyolefin is polyethylene (PE), functionalized into a catalyst or ionomer by sulphonic acid or other electronically active groups. By definition, polyolefins are polymerized versions of basic olefins, i.e. unsaturated hydrocarbons containing a double bond between two carbon atoms.

Olefins, or using a more modern term “alkenes,” as depicted schematically in FIG. 111 comprise styrene monomers 1028 subsequently linked through polymerization to form a supporting backbone 1029. Unlike PTFE, this backbone comprises only hydrocarbons with no fluorine and therefore circumvents ongoing health and environmental concerns regarding fluorocarbon PFAS forever chemicals. Polyolefins represent a distinct class of polymers separate from thermoplastics and other polymer chemistries having the general form (CH₂CHR)ₙ where R is an alkyl group.

Specifically styrene comprises a modified benzene ring 1027 with the chemical formula C₆H₅CH═CH₂ where one of the hydrogen bonds has been substituted by a vinyl group 1026 having a chemical structure —CH═CH₂. During polymerization, the vinyl double bond 1026 is split forming two single bonds with adjacent styrene monomers 1025. Post polymerization, the resulting backbone 1030 of the polyolefin binds the modified benzene rings 1027 together in a string. Structurally analogous to the fluorocarbon backbone in PTFE and PFSA, the polyolefin spine comprises only hydrocarbons. Commercial examples of polyolefin plastics include polyethylene (PE), polypropylene (PP), polyisobutylene, and polymethylpentene (PMP). Shorthand notation often represents polyolefin spine only as the backbone 1030 absent the attached ring structures.

One structural form of a polyolefin suitable for forming an ion exchange membrane (IEM) is the class of polymers referred to as polyethylene aka PE. FIG. 112 depicts an exemplary process flow for fabricating a polyolefin polymer membrane of polyethylene by grafting a bromated hydrocarbon onto a polyethylene backbone. An exemplary process involves two steps, first by grafting sulfuryl chloride onto the polyethylene's backbone 1030, then using reagent 1031 acting on sulfuryl chloride 1032 to perform a substitution with pendant sidechain 1033 with trimethyl amine pendant 1034n.

Finally the trimethyl amine pendant 1034n terminus is modified by into an active bromated ionomer 1035i by bromomethane CH₃Br. Alternatively sulfuric acid H₂SO₄ can be used to form a SO₃H sulfonic acid ionomer. Numerous pragmatic issues challenging the functionalization of PE include managing film porosity, enhancing conductance, and controlling durability as required by real world applications of fuel cells and electrolyzers.

In particular, high density polyethylene (HDPE) sheet is susceptible to environmental stress cracking (ESC), a brittle failure that occurs when the HDPE sheet cracks while in tension. Unsupported, HDPE can fail at tensile stresses lower than normal levels. By combining it with the skeletal support described herein, the tensile strength of a PE membrane can be enhanced significantly.

By adopting the inventive features of the application, the performance of polyethylene (PE) membranes can be greatly enhanced. Improvements include (a) sacrificial fillers to control film porosity and conductivity, (b) endoskeletal support to improve film strength and durability and to reduce swelling, (c) nanoparticle coating to improve interfacial reaction rates, especially on the cathode side where the slower oxygen reduction reaction (ORR) occurs, and (d) doping with fillers and PILs to enhance bulk conductivity in the film.

As previously mentioned, although PE membranes hold promise in fuel cell, electrolysis, and filter applications they can become brittle over time, especially when exposed to light and various chemical agents. They also suffer from high thermal expansion, stress cracking, and poor temperature performance. Some of these deficiencies can be overcome by providing added mechanical support especially during manufacturing, MEA7 assembly, and during operation. As such, membrane integrity can be greatly enhanced through integration with the endoskeletal and exoskeletal support and frame. Given its poor thermal performance, it is important to avoid excessive temperatures.

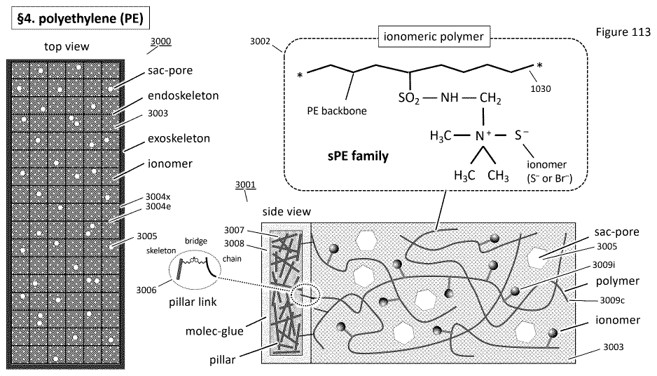

The method of limiting self heating by dividing a fuel cell into micro-stacks is especially valuable in realizing a reliable PE based IEM and fuel cell. In summary, membrane top view 3000 and membrane side view 3001 in FIG. 113 illustrate a variety of elements of a polyolefin ionomeric polymer 3002, in this case comprising polyethylene (PE).

Made in accordance with this invention, inventive features include:
an ion exchange membrane 3003 composed of one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler;
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the polyolefin polyethylene (PE) as mainchain 1030 optionally blended or cross linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel cross-over of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR₄⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

A summary of fabrication conditions for polyethylene IEMs is described in the table below including descriptions of the ionomer, endoskeleton, solvents, and fillers.

| ionomer | structure | endoskeleton | solvents, X-L | fillers |
|---|---|---|---|---|
| §4. functionalized | homopolymer | polymers: PE, EVA, | solv: TCE, xylene, | sac filler, CNTs, |
| polyethylene | PE membrane | EPDM, PU, PP. | toluene, TCB | oxides, POSS, |
| sPE | | pillars: reinforcing | X-L: azo, H₂O₂, | NPs, MOFs, PIL |
| BrPE | | fillers (C-fiber, CNTs) | silane | |

Made in accordance with this invention, a homopolymer membrane comprising a polyethylene (PE) backbone with a trimethyl amine pendant functionalized by an active bromated or sulfonated ionomer terminus is described for fabricating sPE and BrPE IEMs with endoskeletal support. Endoskeletons as disclosed may comprise a range of materials but offer superior bonding to a PE membrane for ethylene-vinyl acetate (EVA) copolymers because EVA contain PE compatible ethylene units; ethylene propylene diene monomers (EPDMs) pursuant to suitable surface treatments increase PE surface bonding energies; polyurethane (PU) as a commonly used post surface treatment PE adhesive; polypropylene (PP) through welding, i.e. localized concurrent melting of PP and PE polymers.

Suitable PE solvents include aromatic hydrocarbons such as trichloroethane (TCE), xylene, toluene, and trichlorobenzene (TCB). PE cross linking agents generate C—C and C—H links. Compounds include azo, i.e. chemicals with a diazinyl (HN═NH) functional group; peroxide (H₂O₂), and silane (SiH₄). Membranes fillers and dopants were described previously and for brevity's sake, will not be repeated here.

In contrast to other polymers, the impermeability of polyethylene to water means its application in hydronium vehicular transport, thereby relegating all conduction mechanisms within the film to either charge hopping along ionomers grafted onto the PE mainchain, or by interaction with ionomeric fillers or ionic liquids. As such, ionomeric conduction in polyethylene films is similar to that of PFSA-PTFE in that charge transport exhibits a surface like behavior rather than bulk conduction.

### § 5. Functionalized Polyvinyl Alcohol (PVA) Polymer IEMs.

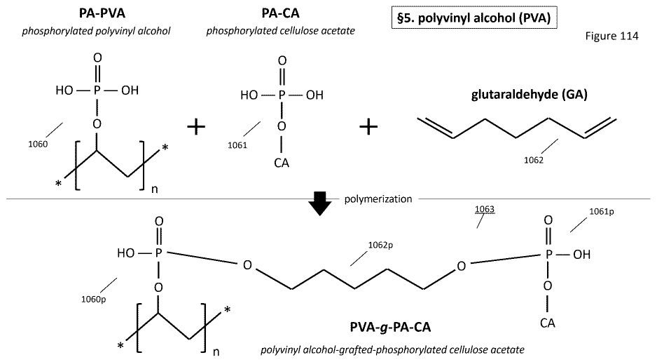

Another fluorine-free category of ion exchange membranes is based on homopolymers, heteropolymers, and copolymers of polyvinyl alcohol (PVA). FIG. 114 describes an exemplary process flow for synthesis of a heterogenous polymer membrane based on combining phosphorylated polyvinyl alcohol (PVA), phosphorylated (PA) cellulose acetate (CA), and glutaraldehyde (GA) to form the polymeric ionomer PVA-PA-CA. As shown, one exemplary process involves a polymerization reaction of phosphorylated polyvinyl alcohol (phos-PVA, pPVA) 1060 with phosphorylated cellulose acetate (phos-CA) 1061 using the crosslinking agent glutaraldehyde (GA) 1062 to yield polyvinyl alcohol-grafted-cellulose acetate 1063 comprising a PVA polymeric backbone 1060p attached via GA pendant 1062p to hydrogen phosphate [HPO₄]²⁻ 1061p also referred to monohydrogen phosphate [PO₃(OH)]²⁻. The terminus hydrogen phosphate in turn bonds to an active ionomer such as cellulose acetate or sulfonic acid.

By phosphorylating PVA and combining it with cellulose acetate PVA can be adapted for use in methanol fuel cell applications. Alternatively, insulating PVA can be functionalized into a conductive ionomer by grafting sulfonic domains at the hydroxyl side group of the polymer backbone or by doping the film with sulfonated graphene oxide.

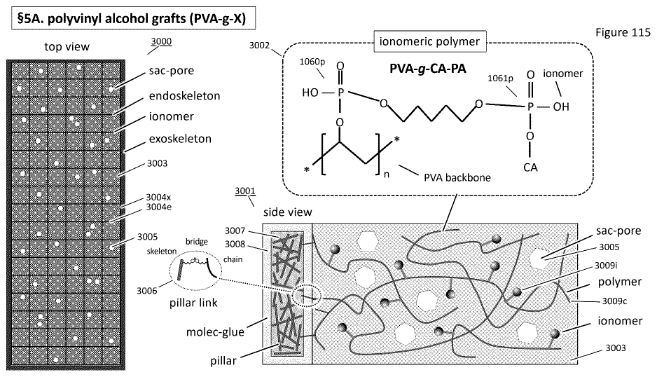

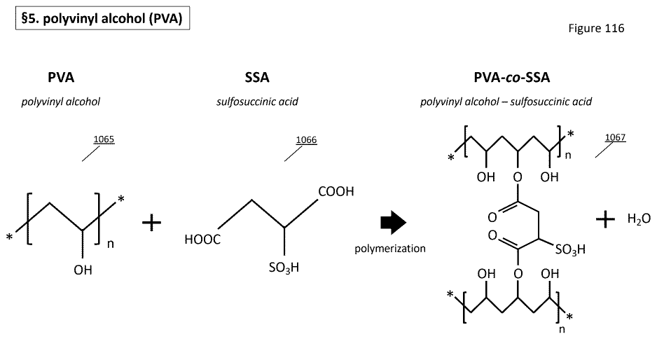

Membrane top view 3000 and membrane side view 3001 in FIG. 115 illustrate a variety of elements of polyvinyl alcohol ionomeric polymer 3002 comprising a grafted polyvinyl alcohol (PVA) made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity or provide protection against membrane poisoning including boron nitride or other materials that inhibit the diffusion of carbon monoxide (CO) into the catalyst layer;
where ionomeric polymer 3002 may comprise poly vinyl alcohol (PVA) 1061p as a mainchain grafted to an ionomer 1061p comprising cellulose acetate (CA) or sulfonated graphene oxide;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; or alternatively by combining phosphoric acid with cellulose acetate (CA) grafted onto the PVA backbone; and finally
where the combination of the endoskeletal pillars and the membrane coating are used to seal in any ionic liquid doping to prevent seepage, leakage, or IL depletion.

Aside from grafting, poly vinyl alcohol can also be functionalized by attaching an aromatic organic compound such as a phenyl as a pendant bound to an ionomer such as sulfonic acid SO₃H. FIG. 116 illustrates a process flow for synthesis of sulfonated polyvinyl polymer where sulfosuccinic acid (SSA) 1066 is used to treat polyvinyl alcohol (PVA) 1065 forming the polymeric ionomer PVA-SSA 1067. For example, two PVA chains may be cross linked by sharing a sulfonated 1,4 di-carbonyl ring for use in pervaporative separation of liquids but made in accordance with this invention PVA membranes can be adapted for ionomeric applications by integrating (a) sacrificial fillers to control film porosity and conductivity, (b) endoskeletal support to improve film strength and durability and to reduce swelling, (c) a nanoparticle coating to improve interfacial reaction rates, especially on the cathode side where the slower oxygen reduction reaction (ORR) limits throughput, and (d) doping with fillers and PILs to enhance bulk conductivity in the film.

In addition to its use in PEM based hydrogen fuel cells, poly vinyl alcohol films can also be adapted for used in direct methanol fuel cells (DMFCs). Methods include doping with H₃PO₂ or H₃PO₄; doping with phosphotungstic acid (PWA) aided by the reagent dimethylsulfoxide (DMSO); blending with chitosan and sodium alginate; and synthesizing PVA-layered silica nanocomposite membranes. Another method involves forming a heterogenous PVA-silica sulfonated membrane employing a trimethoxysilylpropanethiol (TMSP) sol-gel process in the presence of PVA solution.

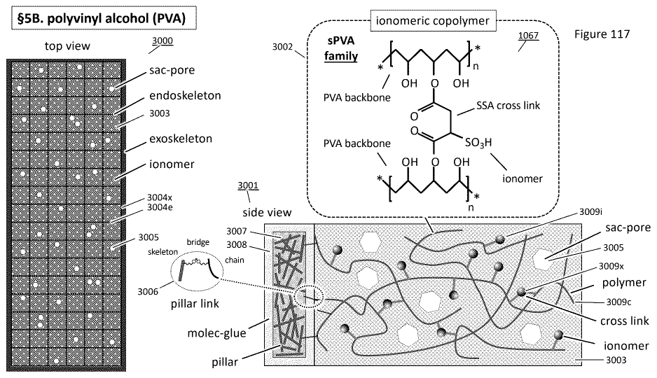

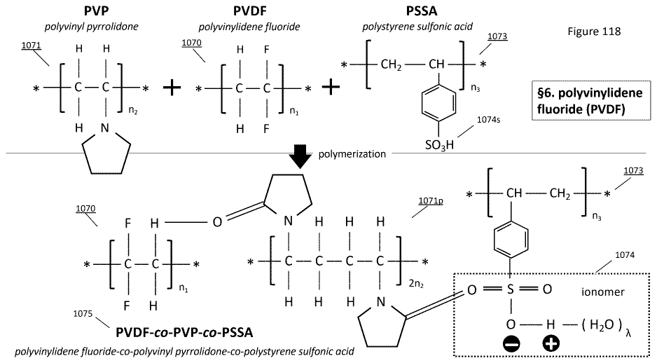

In summary, membrane top view 3000 and membrane side view 3001 in FIG. 117 illustrate a variety of elements of polymer 3002 comprising PVA made in accordance with this invention, including:
an ion exchange membrane 3003 composed of one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the poly vinyl alcohol (PVA) 1067 as a mainchain, optionally blended or cross linked though crosslinking ionomer 1009x to other PVA chains or to dissimilar homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane where the pendants and/or ionomers may also serve to perform crosslinking among chains;
where ionomeric polymer 3002 may comprise an ionomer 3009i or crosslinking ionomer 3009x of reactive sulfonic acid groups —SO₃H, sulfosuccinic acid groups C₄H₆O₇S, carboxylic acid groups —COOH, phosphoric acid groups —PO₃H₂, phosphorous acid PO₄H₂, phosphotungstic acid (PWA), imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, trimethoxysilylpropanethiol (TMSP), or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The below table summarizes various structures, ionomers, endoskeletons, solvents, cross-linkers, and fillers used to synthesize PVA membranes made in accordance with this invention comprising a heterogenous membrane of polyvinyl acid (PVA) homopolymers and heteropolymers with a variety of sidechains, grafts, and copolymers.

| ionomer | structure | endoskeleton | solvents, X-L | fillers |
|---|---|---|---|---|
| §5A. sulfonated polyvinyl | heterogenous | polymer: PVA, PAA, | solv: methanol | sac filler, |
| alcohol | PVA polymers | PEG, PVP, starch | ethanol, DMSO, | CNTs, NPs, |
| sPVA | & copolymers | pillars; reinforcing | DMF, maleic acid, | oxides, PIL |
| PVA-g-CA | | fillers (C-fiber, CNTs) | glyoxal, STMP, CA | POSS, MOFs, |
| PVA-SSA | | | X-L: GA, SHMP, DA, | |
| PVA-co-SSA | | | SA, SSA | |
| §5B. phosphorylated | | | | |
| polyvinyl alcohol | | | | |
| PPVA (PO₃H₂, PO₄H₂) | | | | |
| PWA-PVA | | | | |
| TSMP PVA | | | | |
| chitosan Na-alginate PVA | | | | |

Membrane functionalization includes ionomers of sulfosuccinic acid C₄H₆O₇S; sulfonic acid SO₃H; cellulous acetate (CA); phosphorous acid (H₂PO₄,), phosphoric acid PO₃H₂, phosphotungstic acid (PWA, PTA), and trimethoxysilylpropanethiol groups aka TMSP. Endoskeletons compatible with PVA membranes include polyacrylic acid (PAA) and polyvinylpyrrolidone (PVP), able to form hydrogen bonds with PVA; polyethylene glycol (PEG) able to form copolymers with PVA; starch, able to form biodegradable polymers with PVA, and cellulose such as carboxymethylcellulose (CMC) able to form composites. Suitable PVA solvents include water, dimethyl sulfoxide (DMSO), ethanol, methanol, and dimethylformamide (DMF).

Cross linking agents include glutaraldehyde (GA), glyoxal, maleic acid, citric acid, trisodium trimetaphosphate (STMP), sodium hexametaphosphate (SHMP), dianhydride (DA), succinic acid (SA), and sulfosuccinic acid (SSA). Membranes fillers and dopants were described previously and for brevity's sake, will not be repeated here.

### § 6. Functionalized Polyvinyl Difluoride (PVDF) Polymer IEMs.

Another class of fluorocarbon free ion exchange membranes is based on functionalized homopolymers, heteropolymers, and copolymers of the hydrocarbon polyvinyl difluoride (PVDF). FIG. 118 describes a process flow for synthesis of a PVDF membranes based on combining polyvinylidene fluoride (PVDF) 1070, polyvinyl pyrrolidone (PVP) 1071, and polystyrene sulfonic acid (PSSA) 1073 to form the polymeric ionomer PVDF-PVP-PSSA 1075. The resulting compound comprises three copolymeric chains—polyvinyl pyrrolidone (PVP) 1071, polyvinylidene fluoride (PVDF) 1070, and polystyrene sulfonic acid (PSSA) 1073. Unusually polyvinyl pyrrolidone PVP 1071 not only serves as a polymeric chain but also participates in copolymer cross linking.

In this matrix, the ionomer SO₃H 1074 not only participates in ion exchange but also through hydrogen bonding provides added crosslinking among the chains. One example of PVDF polymerization is used to achieve high actuation response for a polymer metal composites actuator Although the used is in the fabrication of actuators and sensing, in accordance with this application such PVDF synthesis can be adapted and repurposed for ionomer applications such as fuel cells, electrolysis, and filtration by integrating the inventive features of (a) sacrificial fillers to control film porosity and conductivity, (b) endoskeletal support to improve film strength and durability and to reduce swelling, (c) nanoparticle coating to improve interfacial reaction rates, especially on the cathode side where the slower oxygen reduction reaction (ORR) occurs, and (d) doping with fillers and PILs to enhance bulk conductivity in the film.

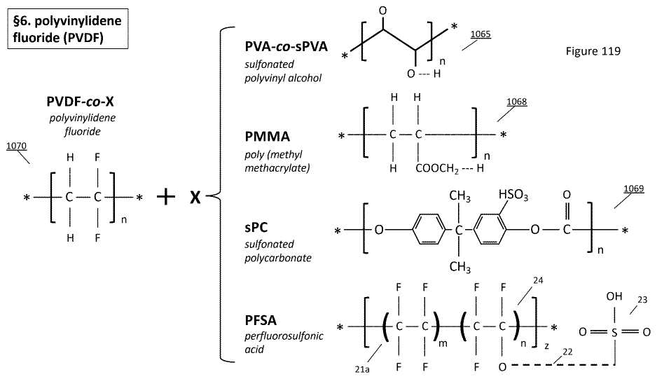

FIG. 119 illustrates exemplary polymers able to bond with polyvinylidene fluoride (PVDF) 1070 in forming ionomeric copolymers. Options include polyvinyl alcohol (PVA) 1065 which can be sulfonated via an extra oxygen bond to produce the copolymer sPVA-PVDF also written as sPVA-co-PVDF; poly(methyl methacrylate) (PMMA) 1068 to produce the copolymer PMMA-PVDF-SA also as PMMA-co-PVDF-SA; sulfonated polycarbonate (sPC) 1069 to produce the copolymer sPC-PVDF also written as sPC-PVDF, and perfluorosulfonic acid (PFSA) 24 yielding PFSA-PVDF also referred to as PFSA-co-PVDF.

In particular the monomer PFSA 24 includes hydrogen bond 22 to sulfonic acid group 23 and inert hydrophobic PTFE chain 21a, or combinations thereof. Various synthesis methods include PVDF/PMMA composite membranes for seawater desalination by gap membrane distillation antifouling for waste water treatment. Although PVDF polymers are used in desalinization and water filtration and the general literature does not discuss or imply their use in fuel cells and electrolysis, the function of PVDF copolymer membranes can be adapted for ionomeric applications by integrating the inventive features of (a) sacrificial fillers to control film porosity and conductivity, (b) endoskeletal support to improve film strength and durability and to reduce swelling, (c) nanoparticle coating to improve interfacial reaction rates, especially on the cathode side where the slower oxygen reduction reaction (ORR) occurs, and (d) doping with fillers and PILs to enhance bulk conductivity in the film.

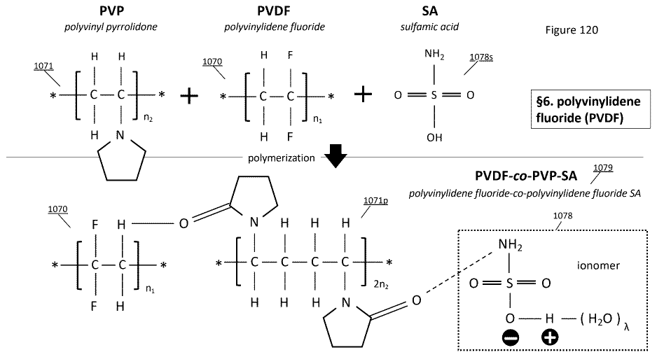

FIG. 120 illustrates process flow for synthesis of a polymer membrane based on combining polyvinylidene fluoride (PVDF) 1070, polyvinyl pyrrolidone (PVP) 1071, and sulfamic acid (SA) 1078s to form the tri-blended 1079 polymeric ionomer PVDF-PVP-SA comprising two polymeric chains PVDF 1070 and functionalized PVP chain 1071p with attached ionomer 1078.

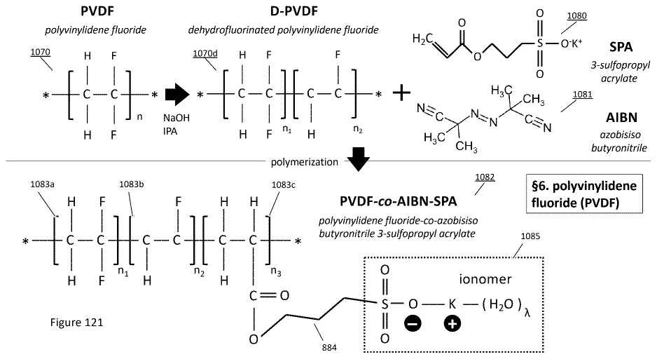

FIG. 121 illustrates a process flow for synthesis of a polymer membrane by converting polyvinylidene fluoride (PVDF) 1070 into dehydrofluorinated polyvinylidene fluoride (D-PVDF) 1070d by stripping hydrogen and fluorine from a segment of the mainchain identified by its repeat length n₂. Portions of the polymer left unmodified are identified by the segment of length n1, whereby the starting length n is split in two so that (n1+n2)=n. The D-PVDF 1070d is next combined with 3-sulfopropyl acrylate (SPA) 1080 and azobisisobutyronitrile (AIBN) 1081 to form tri-blended PVDF copolymer PVDF-AIBN-SPA 1082. The linear copolymer comprises three mainchain constituent components—a PVDF portion 1083a, a dehydrofluorinated segment 1083b, and a hydrocarbon segment 1083c with an attached ionomer 1085 via pendant 884.

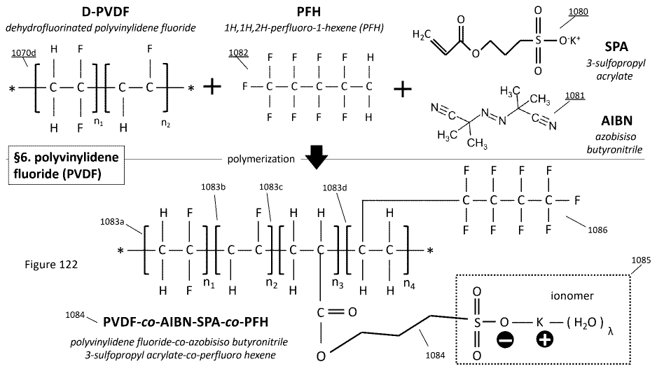

FIG. 122 illustrates a process flow for synthesis of a polymer membrane by combining dehydrofluorinated polyvinylidene fluoride (D-PVDF) 1070d with 1H,1H,2H-perfluoro-1-hexene (PFH) 1082, 3-sulfopropyl acrylate (SPA) 1080, and azobisisobutyronitrile (AIBN) 1081 to form quad-blended PVDF-based copolymer PVDF-AIBN-SPA-PFH 1084 comprising four linear copolymer segments identified as PVDF 1083, dehydrofluorinated PVDF 1083b along with hydrocarbon chains 1083c and 1083d each containing sidechains While hydrocarbon segment 1083d is attached to fluorocarbon copolymer sidechain 1086, hydrocarbon segment 1083c is bonded to pendant 1084 with ionomeric terminus 1085.

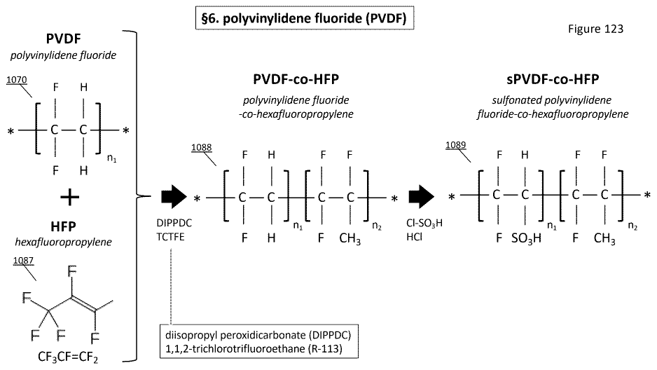

FIG. 123 illustrates a process flow for synthesis of a PVDF-based copolymer membrane by combining polyvinylidene fluoride (PVDF) 1070 and hexafluoropropylene (HFP) 1087 with diisopropyl peroxidicarbonate (DIPPDC) and 1,1,2-trichlorotrifluoroethane (R-113) to produce bi-blended PVDF polymer PVDF-HFP 1088 subsequently sulfonated by treatment in CI-SO₃H and HCl to produce the resulting bi-blended sulfonated PVDF copolymer sPVDF-HFP 1089. A variety of means to synthesize poly(vinylidene fluoride-co-hexafluoropropylene) exist in the scientific literature.

Although published papers discuss various PVDF applications including actuators, filter, and fuel cells, none address the fundamental problematic issues of PVDF membranes, namely excessive swelling, low mechanical strength, poor film durability, and low cathodic reaction rates. By integrating the inventive features of this application, the ionomeric performance of PVDF copolymers can be greatly enhanced. These elements include (a) sacrificial fillers to control film porosity and conductivity, (b) endoskeletal support to improve film strength and durability and to reduce swelling, (c) nanoparticle coating to improve interfacial reaction rates, especially on the cathode side where the slower oxygen reduction reaction (ORR) occurs, and (d) doping with fillers and PILs to enhance bulk conductivity in the film.

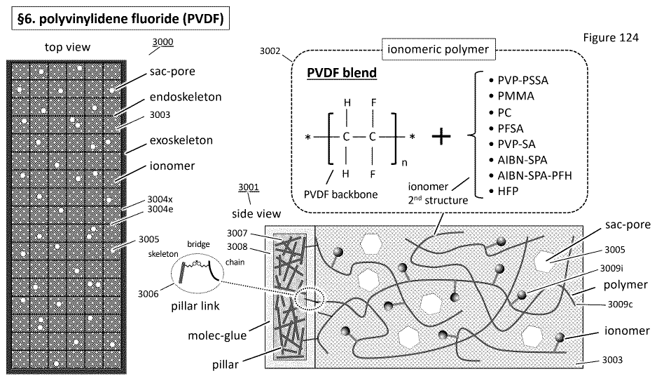

Membrane top view 3000 and membrane side view 3001 in FIG. 124 illustrate a variety of elements of an ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise polyvinylidene difluoride (PVDF) as a mainchain optionally blended or cross-linked to other homopolymers, heteropolymers, copolymers for secondary structure including without limitation PVP-PSSA, PMMA, PC, PFSA, PFSA-PTFE, PVP-SA, AIBN-SPA, AIBN-SPA-PFH, or HFP, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

Made in accordance with this invention, an ion exchange membrane comprising homopolymers, heteropolymers, and copolymers of a polyvinyl difluoride (PVDF) backbone with a variety of sidechains, grafts, and copolymers is disclosed. Examples include PVDF copolymerized with combinations of PVP, AIBN, SPA, HFP, PFH, PC and PFSA.

By controlling the mix of constituent moieties, the blend provides an added degree of structural support whereby the polymer's structure can be considered a heterogenous composite reinforced membrane or CRM. These various PVDF copolymers may be functionalized by sulfonating the copolymer backbones of polystyrene (PS), polyvinyl alcohol (PVA), polycarbonate (PC), perfluorosulfonic acid (PFSA), polyvinyl pyrrolidone (PVP), or by sulfonating dehydrofluorinated portions of a PVDF mainchain.

| ionomer | structure | endoskeleton | solvents, X-L | fillers |
|---|---|---|---|---|
| §6. sulfonated | heterogenous | polymers: PVDF, | solv: DMF, NMP, | sac filler, CNTs, |
| polyvinylidene-fluoride | PVDF CRM | PMMA, PTFE, EVA, | MEK, ace, TEP, | oxides, POSS, |
| PVDF-SA | | PE, PAm, PMP, ABS, | ethanol, esters, | NPs, MOFs, PIL |
| PVDF-PVP-SA | | TPU, PEEK | THF, chloroform. | |
| PVDF-AIBN-SPA | | pillars: reinforcing | X-L: TAIC, MEP, | |
| PVDF-AIBN-SPA-PFH | | fillers (C-fiber, CNTs) | PVP diamines, | |
| PVDF-co-sPVA | | | BPO. | |
| PVDF-PVP-PSSA | | | | |
| PVDF-co-sPC | | | | |
| PVDF-co-PMMA | | | | |
| PVDF-co-PFSA | | | | |

Endoskeletal support compatible to bond with a PVDF membrane include poly(methyl methacrylate) (PMMA), polytetrafluoroethylene (PTFE), ethylene-vinyl acetate (EVA), polyethylene (PE), polymethylpentene (PMP), polyamides (PAm, nylon), acrylonitrile butadiene styrene (ABS), thermoplastic polyurethane (TPU), polyether ether ketone (PEEK), and polyethylene-co-vinyl acetate (EVA). Other endoskeletal materials can be chosen to bond to the corresponding copolymers in the film.

Solvents potentially involved in forming PVDF include dimethylformamide (DMF), N-methyl-2-pyrrolidone (NMP), methyl ethyl ketone (MEK), acetone (ace), ethanol, tetrahydrofuran (THF), chloroform, triethylphosphate (TEP), and various esters. Cross linking agents involved in PVDF synthesis include triallyl isocyanurate (TAIC), and a macromonomer of ethylene oxide—propylene oxide (MEP), diamines such as hexamethylenediamine, benzoyl peroxide (BPO), and polyvinyl pyrrolidone (PVP). Membranes fillers and dopants were described previously and for brevity's sake, will not be repeated here.

### § 7. Polypropylene (PP) CRM Copolymer IEMs.

The hydrocarbon polypropylene (PP) has the potential for use in composite reinforced ion exchange membranes, not as an ionomer but as a copolymer or composite to strengthen mechanical weaker polymers. Electrically, its low surface energy and non-polar hydrophobic nature makes it a poor candidate as a ionomeric conductor. Moreover, its low surface energy also renders it a poor candidate for grafting ionomeric pendants except by using radiation damage. Instead pristine PP is relegated to providing mechanical support in composite reinforced membranes constructed from other polymers better suited for supporting conduction.

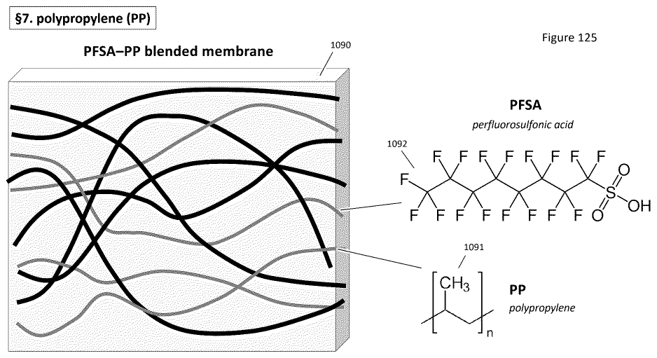

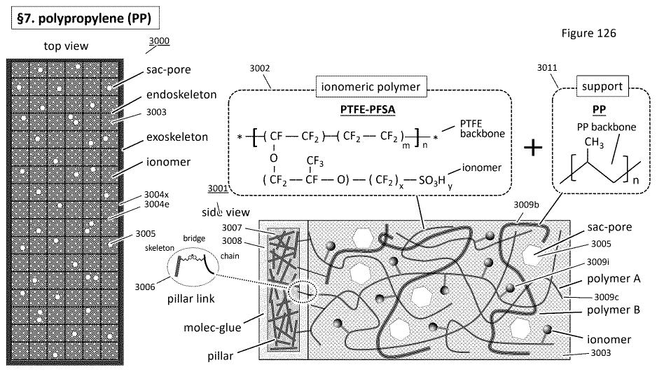

Accordingly, FIG. 125 illustrates the composition of a PP membrane 1090 comprising a blend of intertwined polypropylene (PP) 1091 and perfluorosulfonic acid (PFSA) 1092. Benefits of a blended membrane offer the mechanical strength PP and the conductivity. In processing of a PP-PFSA blend, monomers of polypropylene and of PFSA and PFSA-PTFE are mixed and loaded into a casting mold as described previously in this application. The mixing may comprise solid powder versions of the two monomers or by mixing both components in water, then drying the well blended mix back into powder form.

The monomers used to create PFSA polymers which typically include a vinyl ether with a sulfonyl fluoride precursor group can post polymerization, be hydrolyzed to form the sulfonic acid group. For example, in the case of Nafion® production, the sulfonyl fluoride groups in the monomer can be hydrolyzed to sulfonic acid groups after polymerization. This step is usually done intentionally in a controlled manner to convert the precursor polymer to the functional PFSA polymer with its characteristic ion-exchange properties. The polymerization process itself must however be carefully controlled to ensure that the resulting polymer has the desired molecular weight and properties. Impurities, including water, can affect the polymerization process, but water does not chemically damage the PFSA monomers.

A less attractive alternative involves pre-mixing in solution by dissolving both monomers in a polar-nonpolar solvent mix for example comprising xylene or decalin to dissolve PP monomers and using highly fluorinated solvents, such as perfluorinated alkanes (e.g., perfluorohexane) or perfluorinated ethers to dissolve PFSA. Because however, perfluorosulfonic acid polymers have a unique structure with a hydrophobic fluorocarbon backbone and hydrophilic sulfonic acid groups, strictly speaking they do not dissolve. Instead their structure allows them to swell in polar solvents, particularly in water due to the ionic nature of the sulfonic acid groups, thereby forming a gel-like state rather than a clear solution. As such. blending of PFSA and PP in solution is less attractive than mixing the constituent monomers; Moreover, care must be taken to avoid adverse or exothermic reactions and managing the handling of extremely toxic chemicals.

A more pragmatic solution to synthesize PFSA-PP blended membrane 1090 involves two step process of extruding polypropylene nanofibers using electrospinning and to subsequently lightly crush them into a permanent membrane filler comprising shorter PP snippets or shards. The PP nanofibers are then loaded into a casting mold with PFSA monomers for polymerization. PFSA polymerization is then performed using conventional PFSA membrane synthesis irrespective of the presence of the PP nanofibers.

Note that because the polymerized PFSA does not chemically bond to polypropylene, the membrane is generally considered a blend and not a copolymer. As such, structural integrity is achieved by ensuring one of the two polymers stoichiometrically dominates the matrix and that the two backbones are intertwined to improve the composite mechanical strength. Since the purpose of the membrane is for ion exchange, it means PFSA should comprise a higher mole fraction of the film than PP, rather than the converse. The resulting structure is essentially a PFSA or PFSA-PTFE polymer including a permanent polypropylene nanofiber filler. This process however does not preclude the use of sacrificial fillers described previously to control ionomer porosity or to employ permanent fillers to enhance conductivity.

Membrane top view 3000 and membrane side view 3001 in FIG. 126 illustrate a variety of ionomeric polymers 3002 blended with a second polymer comprising polypropylene made in accordance with this invention, including separately or in combination inventive matter comprising:
an ion exchange membrane 3003 comprising two or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise a copolymer comprising a perfluorosulfonic-acid polytetrafluoroethylene (PFSA-PTFE) mainchain 3009c blended with or bound to backbone 3009b of the polyolefin polypropylene (PP) 3011 as a block copolymer, together controlling film, rigidity, crystallinity, and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

A summary of a PP block copolymer is shown reinforcing an exemplary PFSA ionomer.

| ionomer | structure | endoskeleton | solvents, X-L | fillers |
|---|---|---|---|---|
| §7. polypropylene blend | heterogenous | polymer: PP, PE, | solv: xylene, TCE, | sac filler, CNTs, |
| with ionomeric block | PP CRM | EPDM, TPO, TPE | decalin, tetralin, | oxides, POSS, |
| copolymers | | pillars: reinforcing | TCB. | NPs, MOFs, PIL |
| PFSA-b-PP | | fillers (C-fiber, | X-L: FFA, BM, | |
| PFSA-PTFE-b-PP | | CNTs) | pentane, heptane | |
| other polymers-b-PP | | | | |

As described, the resulting PP block copolymer constitutes a heterogenous composite reinforced membrane (CRM) of the polyolefin polypropylene and an ionomer polymer of either PFSA or PFSA-PTFE. Although PFSA is provided as an example polymer blend, other polymers may substituted for PFSA in the polypropylene supported matrix. Endoskeletal support can be made for pillar links to the ionomeric backbone. Bonding an endoskeleton to the polypropylene, although more difficult, can be achieved using polyethylene (PE) especially if pretreated with a corona or plasma to increase surface energy; ethylene-propylene-diene monomers (EPDM) with suitable adhesives; direct bonding to thermoplastic olefin (TPO), or thermoplastic elastomers (TPE).

Polypropylene solvents include aromatic hydrocarbons such as toluene, decalin, or xylene, or with chlorinated solvents such as trichloroethane (TCE) or trichlorobenzene (TCB). Cross linking agents with starting material maleated polypropylene include furfurylamine (FFA), bismaleimide (BM), dichloromethane (DCM), pentane, and heptane. Membranes fillers and dopants were described previously and for brevity's sake, will not be repeated here.

### § 8. Functionalized Polyvinyl Chloride (PVC) Polymer IEMs.

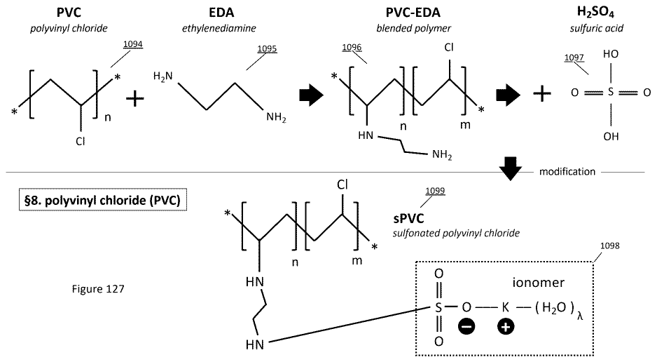

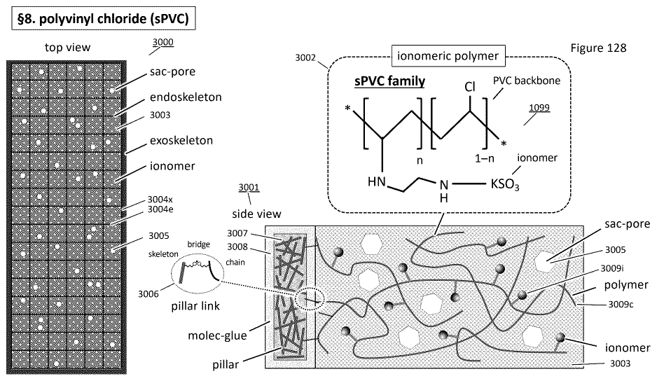

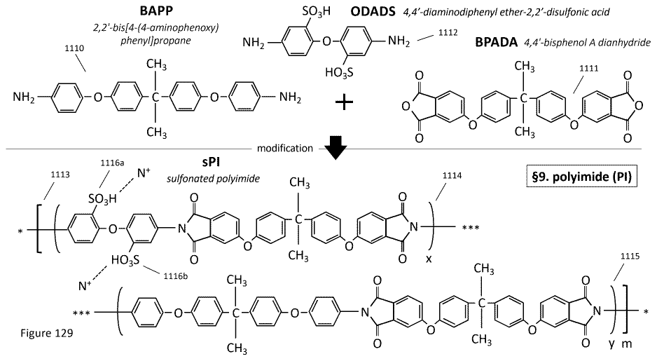

Motivated by demand for non-fluorinated membranes, the hydrocarbon polyvinyl chloride (PVC) can be functionalized as an ionomer or catalyst, and/or grafted onto a copolymer containing ionomeric or catalytic groups. FIG. 127 illustrates an exemplary process flow for synthesis of sulfonated polyvinyl chloride sPVC 1099. The process combines polyvinyl chloride (PVC) 1094 monomers with ethylenediamine (EDA) to produce blended polymer PVC-EDA 1096 comprising two polymer segments, an amino decorated group of length n and a chlorinated segment of length ‘m’. Treating PVC-EDA polymer 1096 with sulfuric acid H₂SO₄ 1097 to produce sulfonated polyvinyl chloride sPVC 1099 with pendant attached ionomer 1098. Sulfonated PVC based membranes offer the potential benefits of immunity to H₂O₂ poisoning, excellent physical and chemical robustness, superior stiffness, and low material cost. In addition to fuel cells, PVC applications include sensors for specific metals, as battery separators, and as filters. As articulated, proton conductivity is heavily dependent on relative humidity and film porosity with the hydrophilicity of the sulfonic acid groups is the main driver of water retention within the polymer. Expectedly, membrane synthesis as reported does not address fundamental problematic issues of membrane swelling, mechanical strength, film durability, and cathodic reaction rates.

By integrating inventive features of this application, the ionomeric performance of sPVC polymers can be greatly enhanced. These elements include (a) sacrificial fillers to control film porosity and conductivity, (b) endoskeletal support to improve film strength and durability and to reduce swelling, (c) nanoparticle coating to improve interfacial reaction rates, especially on the cathode side where the slower oxygen reduction reaction (ORR) occurs, and (d) doping with fillers and PILs to enhance bulk conductivity in the film.

Polyvinyl chloride can also be functioned by grafting to another ionomeric or catalytic polymer. For example, PVC can be grafted onto polyl-vinyl-3-butyilimidazolium (PVC-g-p(VBIm)) ionomers by reacting it with 1-bromobutane and 1-vinylimidazole via quaternization to yield the monomer I-vinyl-3-butyl-imidazolium bromide, subsequently polymerized into P(VBIm) prior to grafting onto PVC. Polyvinyl chloride copolymer membranes such as PVC-g-p(VBIm) are especially beneficial in performing chemical separation and purification, e.g. separating CO₂ from CH₄.

In summary membrane top view 3000 and membrane side view 3001 in FIG. 128 illustrate a variety of elements of an ionomeric polymer 3002 comprising poly vinyl chloride (PVC) made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the polyolefin polyvinyl chloride (PVC) as a mainchain optionally blended or cross-linked to other homopolymers, heteropolymers, copolymers, thereby controlling varying degrees of film crystallinity and anisotropy; or may include grafts to ionomeric or catalytic polymers and ionic liquids such as polyvinyl chloride grafted to polyvinyl butylimidazolium (PVC-g-P(VBIm));
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table summarizes construction of sulfonated poly vinyl chloride (PVC) membrane:

| ionomer | structure | endoskeleton | solvents, X-L | fillers |
|---|---|---|---|---|
| §8A. sulfonated | heterogenous | polymer: PVC, ABS, PC, | solv: DMSO, NMP, | sac filler, CNTs, |
| polyvinyl chloride | PVC polymers | PU, PE, PP, TPE, PMMA, | THF, DMAc, CHN, | oxides, POSS, |
| sPVC | & copolymers | EPX, PVDF, SBR | ace, CPN. | NPs, MOFs, PIL |
| §8B. grafted polyvinyl | | pillars: reinforcing | X-L: GA, STMP, CA | |
| chloride | | fillers (C-fiber, CNT) | SHMP. | |
| PVC-g-p(VBIm) | | | | |

The sulfonated polyvinyl chloride polymer comprises a heterogenous membrane comprising a chlorinated segment and a methylated segment with a corresponding pendant and attached ionomer. PVC forms pillar links amendable to bonding to a spectrum of endoskeletal materials including PVC pillars using PVC adhesives; acrylonitrile butadiene styrene (ABS) using solvent cements or applicable adhesives; polycarbonate (PC) using PVC-PC adhesives, polyurethane (PU) using PU adhesives and sealants; polyethylene (PE) using specialized adhesives can create a bond to low-energy PE surfaces; polyvinylidene fluoride (PVDF) with appropriate surface treatment; or to polypropylene (PP) pillars using molecular glues able to bond polar and non-polar materials. Other endoskeletons bondable by adhesives such as epoxy resins (EPX) may comprise thermoplastic elastomers (TPEs), poly(methyl methacrylate) (PMMA), and styrene-butadiene rubber (SBR).

Solvents used in preparing PVC may include dimethyl sulfoxide (DMSO); 1-methyl-2-pyrrolidinone (NMP); N,N-dimethylacetamide (DMAc); tetrahydrofuran (THF); high concentration acetone (ace), cyclohexanone (CHN), and cyclopentanone (CPN). PVC cross linking agents include glutaraldehyde (GA), sodium trimetaphosphate (STMP), sodium hexametaphosphate (SHMP), and citric acid (CA). Membranes fillers and dopants were described previously and for brevity's sake, will not be repeated here.

### § 9. Functionalized Polyimide (PI) Polymer IEMs.

Another membrane capable of ionomeric conduction is the homopolymer polyimide. FIG. 129 illustrates a process flow for synthesis of a polyimide polymer membrane combining 2,2′-bis[4-(4-aminophenoxy)-phenyl] propane (BAPP) 1110 with 4,4′-diaminodiphenyl ether-2,2′-disulfonic acid (ODADS) 1112 and 4,4′-bisphenol-A dianhydride (BPADA) 1111 to produce sulfonated polyamide (PI) 1113. The PI mainchain comprises two portions −a phenolated dianhydride segment 1115 of length y and a sulfonated portion 1114 of length x containing sulphonic acids 1116a and 1116b. The unit length (x+y) of mainchain 1113 is then repeated m times to define the total polymer length of each distinct chain in the membrane. The conductivity of sulfonated polyimide (sPI) can be temporarily enhanced by doping with a protic ionic liquid. Without the inventive features of the endoskeleton and membrane nanocoating described herein, however the IL will lek out.

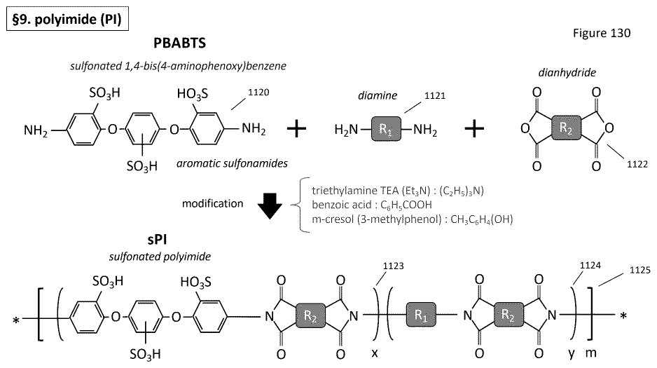

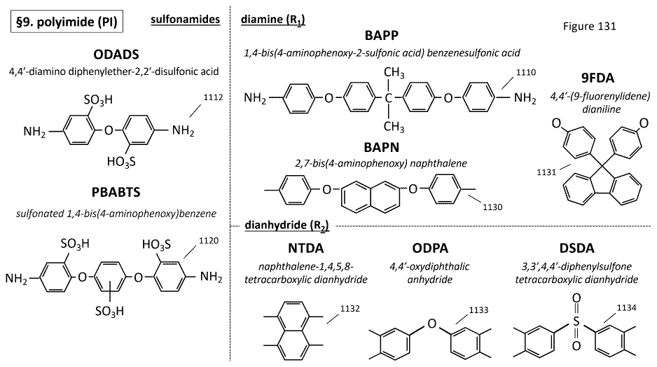

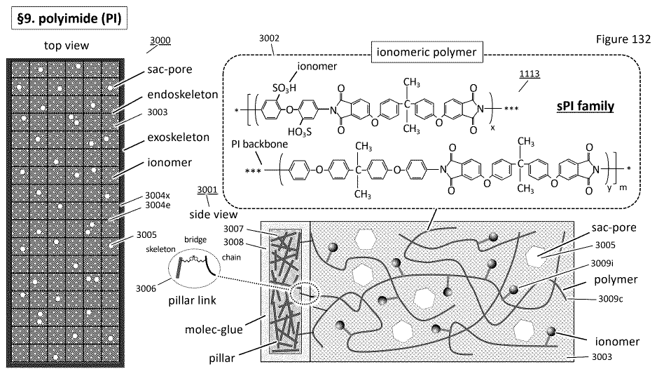

As an alternative implementation, FIG. 130 illustrates an exemplary process flow for synthesis of a polyimide polymer membrane by combining an aromatic sulfonamide such as sulfonated 1,4-bis(4-aminophenoxy)benzene (pBABTS) 1120 with diamine 1121 and dianhydride 1222 to produce sulfonated polyamide (PI) 1125. As depicted diamine 1121 is an amine with precisely two amino (H₂N) groups sandwiching a divalent radical R₁ such as a para-phenylene group. Diamine is commonly used an a monomer in polymer reactions. Dianhydride 1222 is a polymeric curative comprising two anhydride groups surrounding a central radical R₂, which can vary for any number of organic reactive ligands.

The combined mix of diamine, dianhydride, and aromatic sulfonamides is then treated by triethylamine TEA (Et₃N chemically as (C₂H₅)₃N) followed by treatment in benzoic acid (C₆H₅COOH) and m-cresol aka 3-methylphenol (CH₃C₆H₄(OH)) to produce sulfonated polyimide sPI 1125. The resulting sulfonated polyimide comprises polymer segment 1124 of length y containing radicals R₁ and R₂ and aromatic sulfonamide portion 1123 of length x containing radical R₂ plus multiple instances of attached sulfonic acid groups SO₃H. This chain construction benefits from a high degree of sulfonation and associated high conductivity without compromising the polymer's structural integrity. Chemical reagents and polymerizing agents in this process include triethylamine (TEA), benzoic acid, and m-cresol aka 3-methylphenol.

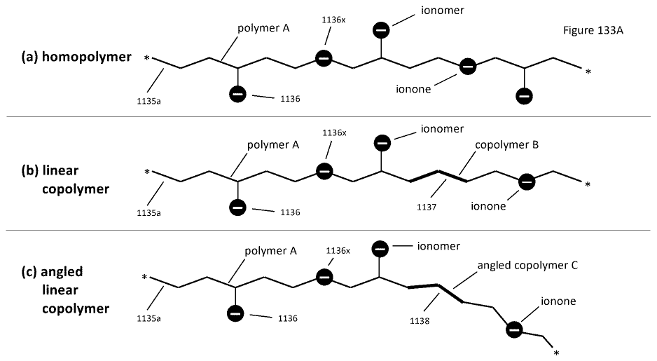

Variants of the three constituent moieties shown in FIG. 131 comprise exemplary molecules for polyimide membrane synthesis categorized into three moieties—sulfonamides, diamines, and dianhydrides. Sulfonamide candidates include 4,4′-diamino diphenylether-2,2′-disulfonic acid (ODADS) 1112 or sulfonated 1,4-bis(4-aminophenoxy)benzene (pBABTS). Diamine R₁ candidates include 1,4-bis(4-aminophenoxy-2-sulfonic acid) benzenesulfonic acid (BAPP) 1110, 2,7-bis(4-aminophenoxy) naphthalene (BAPN) 1130, and 4,4′-(9-fluorenylidene) (9FDA) 1131. Dianhydride R₂ choices include naphthalene-1,4,5,8-tetracarboxylic dianhydride (NTDA) 1132, 4,4′-oxydiphthalic anhydride (ODPA) 1133, and 3,3′,4,4′-diphenylsulfone tetracarboxylic dianhydride (DSDA) 1134.

Various processes exist for synthesizing sulfonated polyimide sPI with protic ionic liquid composite membranes. The published membrane synthesis as reported does not address or anticipate fundamental problematic issues plaquing IEMs and PEMs including IL leakage, membrane swelling, mechanical strength, film durability, and cathodic reaction rates. By integrating the inventive features of this application, the ionomeric performance of sulfonated PI polymers can be greatly enhanced.

These elements include (a) sacrificial fillers to control film porosity and conductivity, (b) endoskeletal support to improve film strength and durability, reduce swelling and prevent ionic liquid leakage, (c) nanoparticle coating to improve interfacial reaction rates, especially on the cathode side where the slower oxygen reduction reaction (ORR) occurs, and (d) doping with fillers and PILs to enhance bulk conductivity in the film.

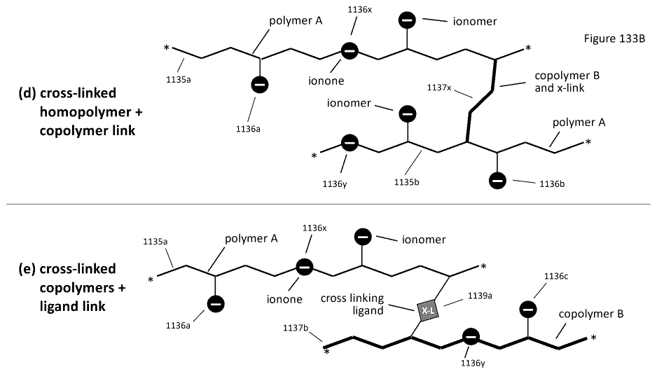

In summary, membrane top view 3000 and membrane side view 3001 in FIG. 132 illustrate a variety of elements of a polyimide (PI) ionomeric polymer 3002 made in accordance with this invention, including separately or in combination inventive matter comprising
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the polyolefin polyimide (PI) 1113 as a mainchain optionally blended or cross-linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

Construction elements of a polyimide (PI) based membrane are listed in the table below including descriptions of the ionomer, endoskeleton, solvents, and fillers.

| ionomer | structure | endoskeleton | solvents, X-L | fillers |
|---|---|---|---|---|
| §9. sulfonated polyimide | heterogenous | polymers: EPX, PI, | solv: DMAc, NMP, | sac filler, CNTs, |
| ODADS, pBABTS | sPI homo- | PTFE, PEEK, PAm | CH₂Cl₂, DMF, THF, | oxides, POSS, |
| BAPP, BAPN, 9FDA | polymer | pillars: reinforcing | DMSO | NPs, MOFs, PIL |
| NTDA, ODPA, DSDA | | fillers (C-fiber, CNTs) | X-L: see solvents | |

As detailed above, a sulfonated polyimide membrane comprises a heterogenous polymer composed of functional radicals including the sulfonamides 4,4′-diamino diphenylether-2,2′-disulfonic acid (ODADS) and sulfonated 1,4-bis(4-aminophenoxy)benzene (pBABTS); diamines (R₁), of 1,4-bis(4-aminophenoxy-2-sulfonic acid) benzenesulfonic acid (BAPP), 2,7-bis(4-aminophenoxy) naphthalene (BAPN), and 4,4′-(9-fluorenylidene) dianiline (9FDA); and dianhydrides (R₂) of naphthalene-1,4,5,8-tetracarboxylic dianhydride (NTDA), 4,4′-oxydiphthalic anhydride (ODPA), and 3,3′,4,4′-diphenylsulfone tetracarboxylic dianhydride (DSDA).

Endoskeletal materials able to bond to polyimide support pillars include epoxy resins EPX, polytetrafluoroethylene (PTFE) subject to surface treatment, polyether ether ketone (PEEK) using select high-temperature adhesives, or polyamide (PAm, nylon) using suitable adhesives able to bond to both polymer types. The role of solvents in fabricating polyimide is to enable a reaction between a dianhydride and a diamine under ambient conditions using a dipolar aprotic solvent. Examples include such as N-methylpyrrolidinone (NMP), m-cresol, N,N-dimethylacetamide (DMAc), N,N′-dimethylformamide (DMF), dichloromethane (CH₂Cl₂), dimethyl sulfoxide (DMSO), and to a lesser extent tetrahydrofuran (THF). Polymerization of PI involves reacting a dianhydride and a diamine at ambient conditions in a dipolar aprotic solvent, so that no specific polymerizing or cross linking agent is required other than the solvents present in synthesis. Membrane fillers and dopants were described previously and for brevity's sake, will not be repeated here.

### § 10. Functionalized Polystyrene (PS) Polymer IEMs.

Pure polystyrene, i.e. polystyrene (PS) homopolymers represent a class of polymers that is an amorphous thermoplastic that is rigid, brittle and relatively hard with poor chemical resilience. To improve its mechanical and temperature performance, PS is often cross linked to itself or used to form copolymers with other polymeric materials.

To better understand the need and benefit of cross linking and copolymerization, we must first consider what are the various constructions of homopolymers, cross linked homopolymers, and copolymers. In the lexicology of polymers, a homopolymer is a linear chain of homogenous monomers bound together during the process of polymerization. In contrast, a copolymer is a polymer that is made of two or more monomer species. The polymer is bound to its copolymer counterpart through chemical bonding which may involve another polymer serving as a bridge or through a organic ligand generally involving covalent bonds.

For long chains, copolymer bonding may also comprise hydrogen bonds which gain strength through a large number of interchain electrostatic attraction points. As a subtle point, the process of concurrently forming bonds between multiple polymeric chains during formation of a homopolymer is referred to as polymerization, whereas the process of forming bonds between multiple dissimilar polymeric chains during film formation is called copolymerization. By contrast, the bonding of a polymeric to another or to another portion of the same chain is referred to as cross-linking.

As such, cross linked chains may bond multiple chains of the same material, of dissimilar materials, or may form loops on its own chain. Although cross linking may occur during polymerization or be performed subsequent to synthesizing the polymer, as a matter of semantics reagents causing cross chain bonding during polymerization are referred to polymerizing agents while those used to cause cross linking after polymerization are commonly referred to a cross linking agents. For simplicities sake, herein we use terms of polymerizer and cross-linker (X-L) as interchangeable, to be understood in the context of the reaction being discussed.

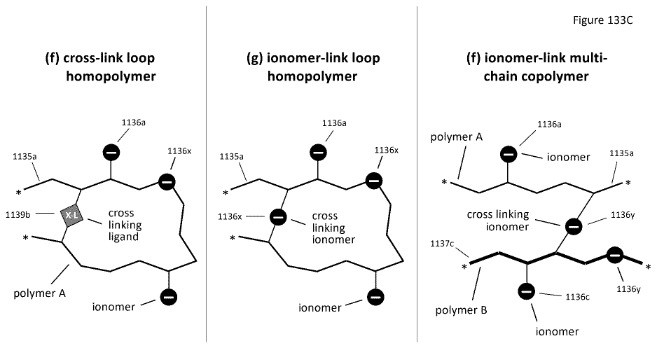

To clarify FIG. 133A illustrates a comparison of homopolymer, copolymer, and angled copolymer molecules. As depicted in case (a), homopolymer-A 1135a comprises a single homogenous polymer of a specific chemistry with attached side groups pendants and ionomers 1136. The sidechains are not considered as polymers despite oftentimes comprising nearly the same composition as the mainchain. In case (b), a portion of polymer-A 1135a is interrupted by polymer-B 1137 which is in line with polymer-A, i.e. forming a linear topography. In case (c), the bonding angle of copolymer-C 1138 differs from that of polymer-A 1135a causing the direction of the polymer to break off angle from the mainchain. Despite having different angles, both case (b) and (c) represent linear copolymers.

By contrast, FIG. 133B illustrates multi-chain copolymers, where the second polymer does nor interrupt polymer-A but instead cross links to it. In case (d), two identical homopolymer strings 1135a and 1135b each comprising polymer-A having respective ionomers 1136a and 1136b are linked by copolymer-B 1137x which serves to cross-link the two polymer-A strands. In case (e), two dissimilar strands polymer A 1135a with ionomer 1178a and copolymer B 1137b with ionomer 1136c are bridged by cross linked ligand 1139a.

FIG. 133C illustrates in case (f) where a cross linking ligand 1139b forms a loop to its own mainchain polymer 1135a. In case (g) ionomer 1136x forms a bridge between two portions of a common chain 1135a. In some instances as shown in case (h) chain-to-chain bonding can be accomplished by sharing a common ionomer 1136y between polymer A 1135a and copolymer B 1137c. Depending on the specific ionomer performing chain-to-chain bridging, cross linking ionomer 1136y may lose the ability of ionomeric conduction and charge transport offered by ionomers 1136a and 1136c.

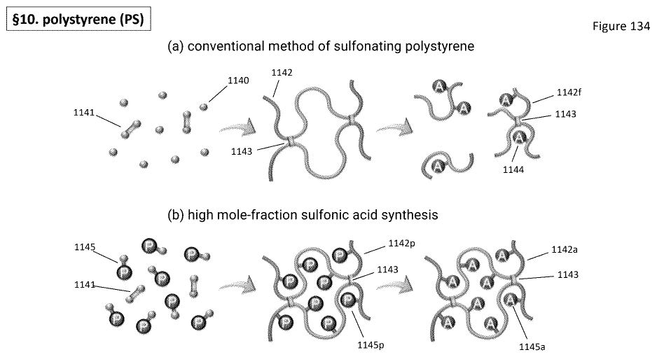

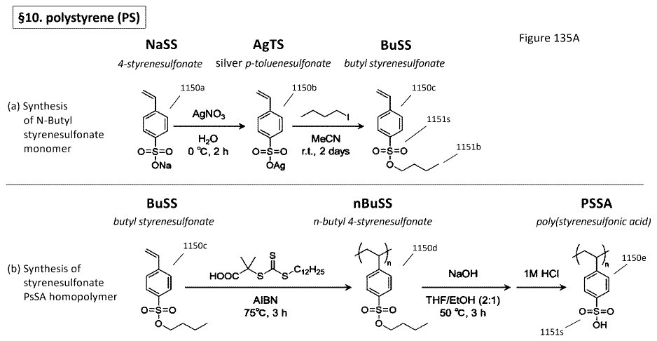

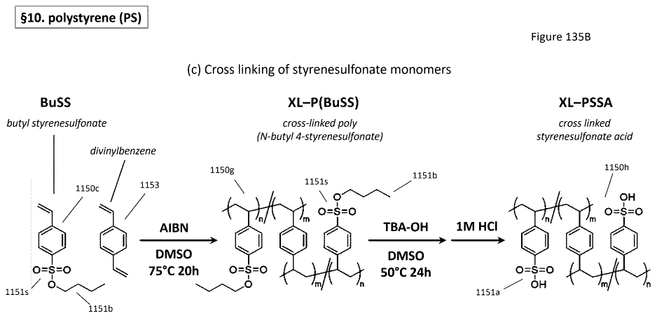

Given the forgoing, FIG. 134 illustrates a process flow for fabricating sulfonated heteropolymer polystyrene (PS) involving either a conventional method or a high mole-fraction sulfonic acid synthesis. In one exemplary process comprising a ultra-high density of sulfonic acid monomers comprising styrene 1140 and divinylbenzene 1141 are polymerized with polystyrene and cross linkages 1143. During sulfonation to attach acids 1144 to the polystyrene, the PS chain is broken into snippets comprising PS fragments 1142f with or without cross linker 1143.

In an alternative process styrenesulfonate 1145, a styrene monomer is combined together with divinylbenzene 1141 then polymerized with poly(styrenesulfonate) 1142p, where the poly(styrenesulfonate) contains protected sulfone groups 1145p and on-chain bridging 1143. In the final step, the protected sulfone groups 1145p are functionalized, i.e. deprotected, forming sulfonic acid groups 1145a thereby transforming cross-linked poly(styrenesulfonate) 1142p into cross-linked poly(styrenesulfonic acid) 1142a.

FIG. 135A illustrates an alternative process flow for fabricating a sulfonated heteropolymer polystyrene in the form of cross-linked styrenesulfonate. In steps (a), N-butyl styrenesulfonate (BuSS) 1150c, a styrene monomer, is formed from sodium 4-styrenesulfonate (NaSS) 1150a dissolved in an aqueous solution of AgNO₃ producing silver p-toluenesulfonate (AgTS) 1150b. The compound is the treated by acetonitrile (MeCN, methyl cyanide) resulting in n-butyl styrenesulfonate (BuSS) monomer 1150c containing a sulfonic group 1151s and butyl group 1151b.

In the second stage shown in steps (b) n-butyl styrenesulfonate monomer (BuSS) 1150c is first treated with azobisisobutyronitrile (AIBN) and dodecyl-dimethyl-acetic-acid)-trithiocarbonate (DDMAT) to form the intermediary compound N-butyl 4-styrenesulfonate (NBuSS) 1150d then dissolved in sodium hydroxide (NaOH) and a blend of tetrahydrofuran (THF) and ethanol (EtOH) and after stirring in a solution of HCl in ethanol, subsequently precipitated. The precipitate, a homopolymer poly(styrenesulfonic acid) (PSSA) 11150e includes sulfonic acid homopolymer 1151s.

Alternatively, steps (c) in FIG. 135B illustrates formation of a cross-linked copolymer of styrenesulfonic acid. As shown the process involves starting with the polystyrene monomer butyl styrenesulfonate (BuSS) 1150c mixed with divinylbenzene 1153, then polymerized with azobisisobutyronitrile (AIBN) and dimethyl sulfoxide (DMSO) to produce the cross-linked polymer poly(N-butyl 4-styrenesulfonate) (XL-P(BuSS)) with a mainchain 1150g, sulfonic ionomer 1151s, and butyl group 1151b. Subsequent processing with tetrabutylammonium hydroxide (TBA-OH) and 50° C. dimethyl sulfoxide (DMSO) followed with hydrochloric acid (HCl) to form polymeric precipitates cross-linked poly(styrenesulfonate acid) PSSA copolymers 1150h with ionomer 1151h.

Published works on polystyrene polymeric membrane synthesis do not however address or anticipate fundamental problematic issues plaquing IEMs and PEMs including membrane swelling, mechanical strength, film durability, and cathodic reaction rates. By integrating the inventive features of this application, the ionomeric performance of sulfonated PS polymers can be greatly enhanced. These elements include (i) sacrificial fillers to control film porosity and conductivity, (ii) endoskeletal support to improve film strength and durability and to reduce swelling, (iii) nanoparticle coating to improve interfacial reaction rates, especially on the cathode side where the slower oxygen reduction reaction (ORR) occurs, and (iv) doping with fillers and PILs to enhance bulk conductivity in the film.

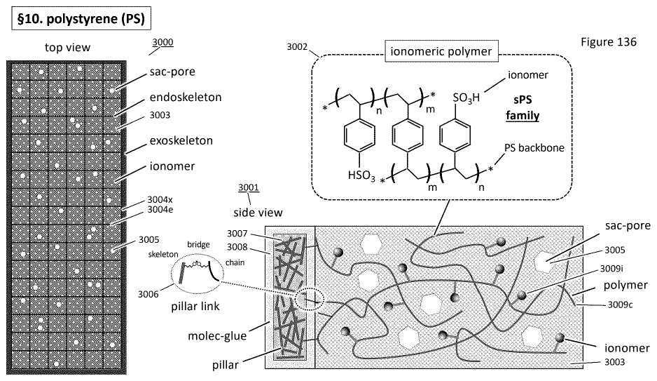

Membrane top view 3000 and membrane side view 3001 in FIG. 136 illustrate a variety of elements of polystyrene ionomeric polymers 3002 made in accordance with this invention, including separately or in combination inventive matter comprising
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the thermoplastic heteropolymer polystyrene (PS) as a mainchain optionally blended or cross-linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table describes various components of a polystyrene ionomeric film:

| ionomer | structure | endoskeleton | solvents, X-L | fillers |
|---|---|---|---|---|
| §10. sulfonated | heterogenous | polymers: PS, ABS, PC, | solv: DVBz, DMSO, | sac filler, CNTs, |
| polystyrene | PS polymer & | PVC, PU, PE, PMMA, | ace, toluene, ethyl | oxides, POSS, |
| SPS | X-L copolymers | PET, PAm, TPE EPX. | acetate, THF, DCM | NPs, MOFs, PIL |
| PSSA | | pillars: reinforcing fillers | X-L: DVBz, DBPO | |
| XL-PSSA | | (C-fiber, CNTs) | HMe—BnCl | |

A heterogenous sulfonated polystyrene (PS) membrane as described comprises a sulfonated polystyrene (SPS) polymer, poly(styrenesulfonic acid) PSSA; and crosslinked (X-L) styrenesulfonate acid (PSSA). Endoskeletal materials compatible for bonding with PS include polystyrene (PS); acrylonitrile butadiene styrene (ABS), a similar polymer easily bonded by cyanoacrylate or acrylic-based adhesives; polycarbonate (PC), easily bonded to polystyrene using adhesives such as polystyrene cement, epoxy, or solvent-based adhesives; polyvinyl chloride (PVC) bonded by adhesives like cyanoacrylates, epoxies, or solvent-based adhesives; polyurethane (PU) bonding to polystyrene via polyurethane-based adhesives or other compatible glues; poly(methyl methacrylate) (PMMA, acrylic) bonded to polystyrene using solvent-based adhesives that can slightly dissolve the surface of both polymers, creating a strong bond as the solvents evaporate.

Other endoskeletal materials include polyethylene terephthalate (PET), bondable to PS sing adhesives that are compatible with both materials, such as certain epoxies or UV-curable adhesives; polyamide (PAm, nylon) bondable using adhesives like epoxy or with the aid of a primer that can enhance the adhesion between the two polymers; thermoplastic elastomers (TPE) using glue compatible with both materials. More difficult skeletal material candidates to bond include polyethylene (PE) and polypropylene, both of which require prebonding treatments such as radiation or plasmas to induce damage sites for dangling bonds or defects on which PS can attach.

Solvents for polystyrene include most organic solvents including divinyl benzene (DVBz), dimethyl sulfoxide (DMSO), acetone (ace), toluene, ethyl acetate, tetrahydrofuran (THF), and dichloromethane (DCM). Cross linking agents for PS synthesis include p-hydroxymethyl benzyl chloride (HMe-BnCl), divinyl benzene (DVBz), and dibenzoyl peroxide (DBPO). Membrane fillers and dopants were described previously and for brevity's sake, will not be repeated here.

### § 11. Functionalized Poly Fluorenyl Ether Ketone Nitrile (PFEKN) Polymer IEMs.

Another homopolymer, poly (fluorenyl ether ketone nitrile) P(FEKN) is a candidate for high temperature fuel cell applications, especially for operation over 80° C. Although sulfonated poly (fluorenyl ether ketone nitrile) polymers have been used to form low equivalent weight P(FEKN) membranes via one-step polycondensation from commercial raw materials, their measured electrical and mechanical properties were not competitive to other IEM polymers and limited to only high temperature operation.

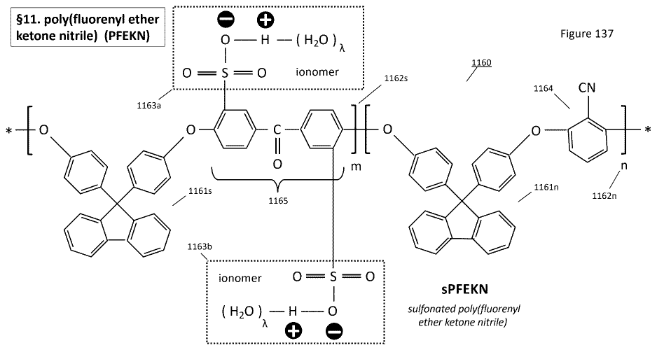

FIG. 137 illustrates the chemical structure of sulfonated poly (fluorenyl ether ketone nitrile) 1160. As a heteropolymer, the main contains two moieties, one sulfonated the other un-sulfonated. Specifically segment 116n of length ‘n’ contain a four-benzene crosslinked compound 4,4′-(9-fluorenylidene)diphenol (BPFL) 1161n and a linearly attached benzonitrile group 1164, i.e. an aromatic hydrocarbon molecule consisting of a benzene ring functionalized by a cyano (CN) group with an equivalent formula C₆H₅CN. The benzonitrile group 1164 is responsible for the nominative ‘nitrile’ in the polymer's name.

The second segment 1162s of length m represents the sulfonated group in the heterogenous polymer. Specifically it comprises another BPFL groups 1161s attached to an ether-ketone group 1165 to which two SO₃H ionomers 1163a and 1163b attach. The total length (m+n) of a unit cell contains eleven aromatic hydrocarbon rings largely responsible for controlling the porosity of the cell. Conventional P(FEKN) membrane synthesis does not address or anticipate fundamental problematic issues plaguing their use in IEMs and PEMs including membrane swelling, mechanical strength, film durability, and cathodic reaction rates. By integrating the inventive features of this application, the ionomeric performance of sulfonated P(FEKN) polymers can be greatly enhanced. These elements include (a) sacrificial fillers to enhance film porosity and conductivity, (b) endoskeletal support to improve film strength and durability and to reduce swelling, (c) nanoparticle coating to improve interfacial reaction rates, especially on the cathode side where the slower oxygen reduction reaction (ORR) occurs, and (d) doping with fillers and PILs to enhance bulk conductivity in the film. None of these features are anticipated in any reported studies.

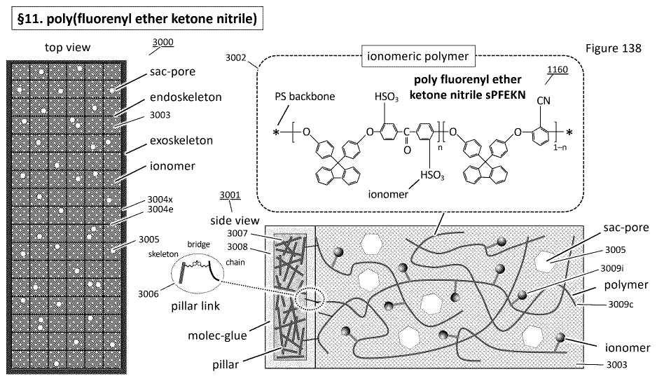

Membrane top view 3000 and membrane side view 3001 in FIG. 138 illustrate a variety of elements of ionomeric polymer 3002 made in accordance with this invention, including separately or in combination inventive matter comprising
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the thermoplastic heteropolymer poly(fluorenyl ether ketone nitrile) 1160 as a mainchain optionally blended or cross-linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte;
where the combination of the endoskeletal pillars and the membrane coating seal in any ionic liquid doping to prevents seepage, leakage, or IL depletion; and finally
where the combination of the endoskeletal pillars and the membrane coating are used to seal in any ionic liquid doping to prevent seepage, leakage, or IL depletion.

Features of sulfonated poly fluorenyl ether ketone polymers are described in the table below:

| ionomer | structure | endoskeleton | solvents, X-L | fillers |
|---|---|---|---|---|
| §11. sulfonated poly | heterogenous | polymers: PEEK, | solv: DMAC, | sac filler, CNTs, |
| fluorenyl ether ketone | FEKN polymer | PPS, PI, TPU. | BHPF, DMSO | oxides, POSS, |
| nitrile | | pillars; reinforcing | X-L: DHPhthal | NPs, MOFs, PIL |
| sPFEKN | | fillers (C-fiber, CNTs) | | |

As described sPFEKN is a heteropolymer comprising a sulfonated chain of fluorenylidene diphenol groups bridged by alternating benzonitrile and ether-ketone groups. Endoskeletal compositions compatible with bonding to the membrane include polyether ether ketones (PEEK), polyphenylene sulfide (PPS), polyimide (PI), and thermoplastic polyurethane (TPU). Solvents include reagents similar to those used with PEEK and PEK films including N-dimethyl-acetamide (DMAC), bisphenol fluorene (BHPF), and dimethylsulfoxide (DMSO). Cross linking agents include 2-dihydro-4-(4-hydroxyphenyl)-1(2H)-phthalazone (DHPhthal). Membrane fillers and dopants were described previously and for brevity's sake, will not be repeated here.

### § 12. Functionalized Polyphenylene (PPh, PP) Polymer IEMs.

Another broad class of polymers amenable to synthesis of non-fluorinated ion exchange membrane membranes is polyphenylene. Polyphenylenes are macromolecules which comprise benzenoid aromatic nuclei directly joined to one another by C—C bonds. As a hydrocarbon based polymer, polyphenylene exhibits a number of beneficial material and electrical qualities. For example, one member of the chemical family, poly (p-phenylene) (PPhP, PPP) can be transformed from an electrical insulator into an electrical conductor or ionomer by doping with electron acceptors or donors. Polyphenylene ether (PPhE, PPE) is noted for its ability to survive temperatures of 320° C. or higher without melting making it a good prospective candidate for high temperature fuel cells.

It should be noted while it is common practice to abbreviation polyphenylene by the acronym PP, this terminology is identical to the abbreviation for another polymer, polypropylene. As such, throughout this patent unless specifically identified as an exception or contained in an exhaustive list of terms, the acronym PP shall mean polypropylene and the acronym PPh shall mean polyphenylene. This nomenclature is consistent with the convention that phenyl is ofttimes denoted as Ph in chemical formulas to distinguish it from phosphorus P.

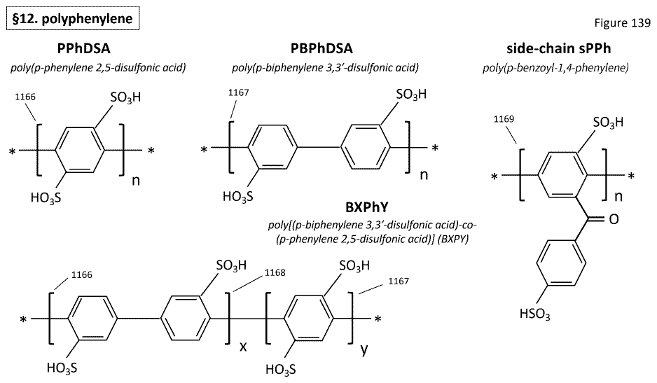

FIG. 139 illustrates the chemical structures of heteropolymer precursors for polyphenylene synthesis including poly(p-phenylene 2,5-disulfonic acid) (PPhDSA, PPDSA) 1166, poly(p-biphenylene 3,3′-disulfonic acid) (PBPhDSA, PBPDSA) 1167, poly(p-benzoyl-1,4-phenylene) also referred to as sulfonated sidechain polyphenylene 1169 (sPPh, sPP), and poly[(p-biphenylene 3,3′-disulfonic acid)-co-(p-phenylene 2,5-disulfonic acid)] (BXPhY, BXPY).

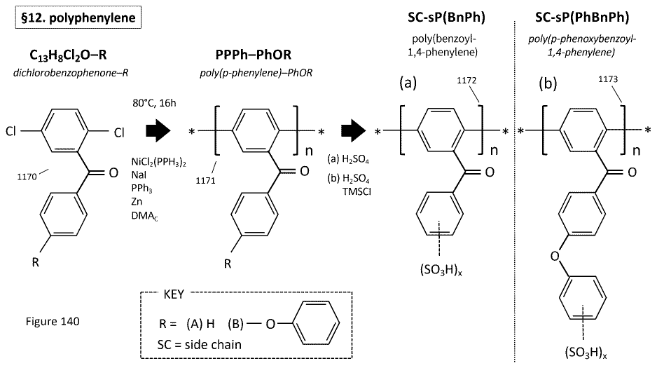

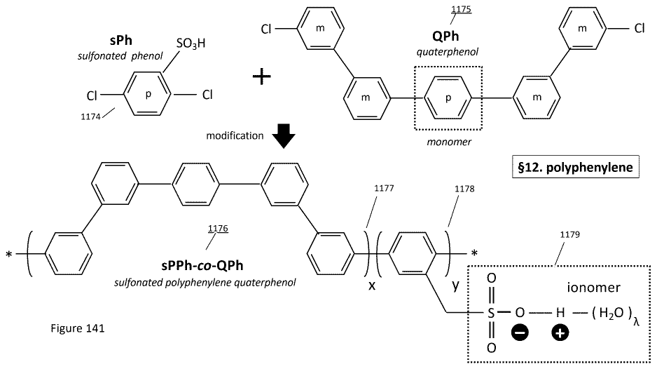

FIG. 140 illustrates one possible process flow for fabricating sulfonated polyphenylene heteropolymers comprising two PPh moieties, namely (a) poly(benzoyl-1,4-phenylene, and (b) poly(p-phenoxybenzoyl-1,4-phenylene). Synthesis starts with dichlorobenzophenone-R having the chemical composition C₁₃H₈Cl₂O—R where R is a radical comprising either hydrogen or phenolate ions. The starting material is then treated by reagents bis(triphenylphosphine) nickel(II) dichloride (NiCl₂(PPh₃)₂); sodium iodide (NaI); triphenylphosphine (PPh₃); zinc (Zn); and dimethylacetamide (DMAc) at 80° C.

The process results in a precursor molecule poly(p-phenylene)-phenyloxide-R (PPPh-PhOR) where phenyloxide-R represents an attached sidechain (SC) of a phenol-oxide bound to the radical R. In case (a), treatment of PPPh-PhOR 1171 with sulfuric acid (H₂SO₄) resulting in the sidechain polymer poly(benzoyl-1,4-phenylene)SC-sP(BnPh) 1172. Alternatively, PPPh-PhOR 1171 treated with sulfuric acid blended with trimethylsilyl chloride (TMSiCl, TMSCl) results in an extended sidechain polymer poly(p-phenoxybenzoyl-1,4-phenylene) (SC-sP(PhBnPh)) 1173.

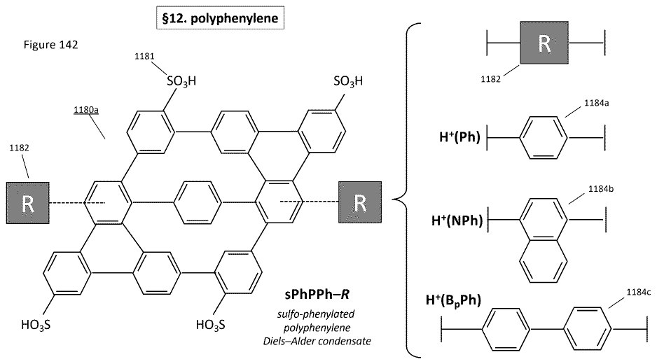

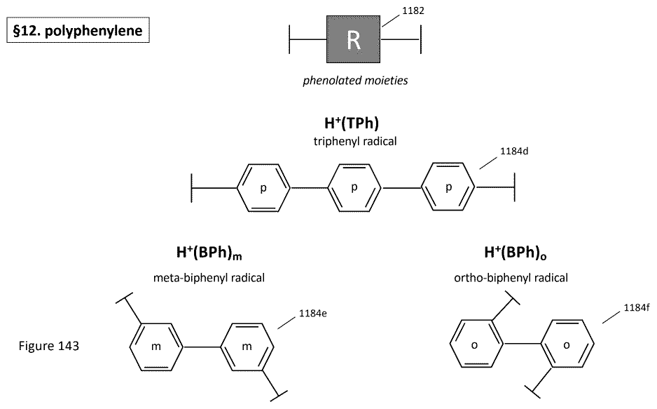

FIG. 141 illustrates the process flow for fabricating the heteropolymer sulfonated polyphenylene quaterphenol (SPPh-QPh) 1176 comprising sulfonic acid ionomer 1179 constructed from monomers sulfonated phenol (SPh) and quaterphenol (QPh) 1175. FIG. 142 depicts a sulfophenylated polyphenylene (sPhPPh) 1180a as a comprising a generic heteropolymer with sulfonic acid (SO₃H) ionomers 1180 and radical groups 1182.

For radical R=H⁺(Ph) 1184a, the resulting linear polymer is sPhPPh-H⁺ or alternatively as sPPP-H⁺. For radical R=H⁺(NPh) 1184b, the resulting non-linear polymer is sPhPPh-NH⁺ or alternatively sPPP-NH⁺. For radical R=H⁺(BPh)ₚ=H⁺(BPh) 1184c, the resulting para-biphenyl polymer is sPhPPh-(BₚPh)H⁺or alternatively sPPP-(BₚPh)H⁺. Continuing in FIG. 143, with radical R═H⁺(TPh) 1184d the resulting sulfonated polyphenylene triphenol polymer is sPhPPh-(TPh)H⁺ or alternatively sPPP-(TP)H⁺. For a meta-biphenyl radical R=H⁺(BPh)m 1184e, the resulting sulfonated polyphenylene biphenyl polymer is sPhPPh-(BPh)ₘH⁺ or alternatively as sPPP-(BPh)ₘH⁺. For an ortho-biphenyl radical R═H⁺(BPh)ₒ 1184f, the resulting sulfonated polyphenylene biphenyl polymer is sPhPPh-(BPh)ₒH⁺or alternatively as sPPP-(BPh)ₒH⁺.

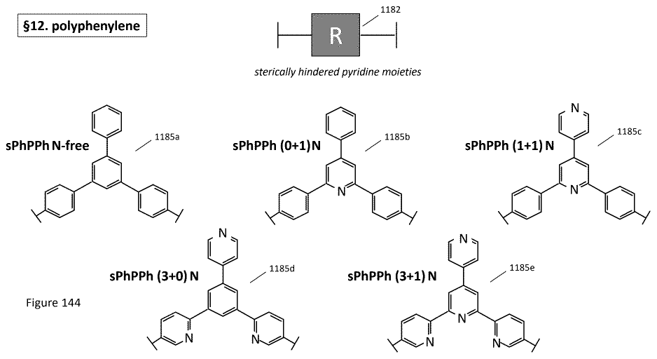

Other radicals R 1182 shown in FIG. 144 include various Y configured groups of four benzene aromatic rings comprising a center and three branches. Sterically hindered pyridine moieties can be categorized by the replacement of carbon with nitrogen either on the center aromatic ring or the branches therefrom. For example, sPhPPh N-free 1185a is absent any N substitutions, while (0+1)N moiety 1085b has only a center nitrogen, (1+1)N moiety 1085c has N located on the center ring and one branch, (3+0)N moiety 1085d has nitrogen on the branches but not in the center, and (3+1)N moiety 1185e has every ring populated by one nitrogen substitution.

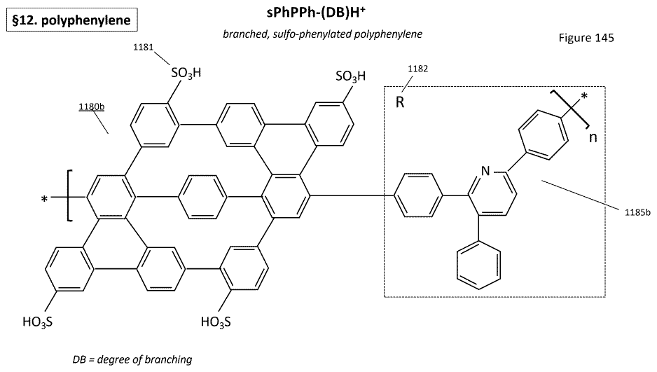

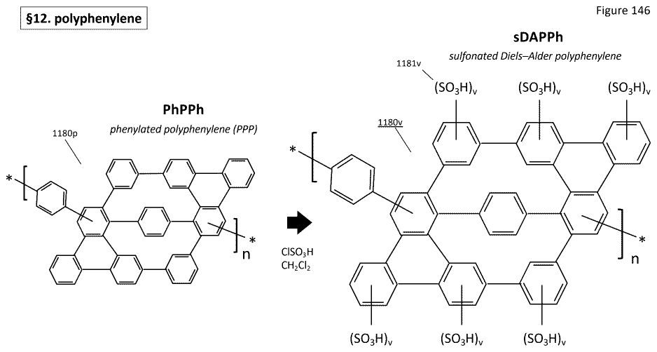

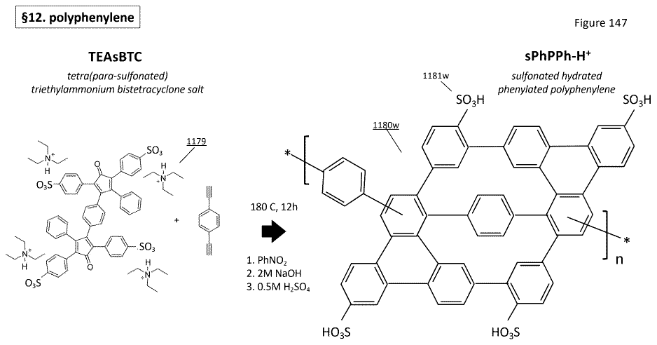

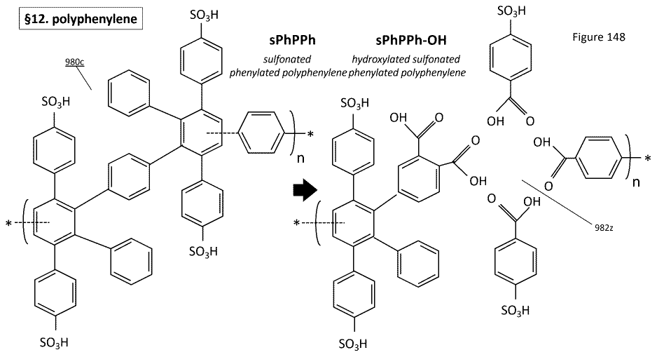

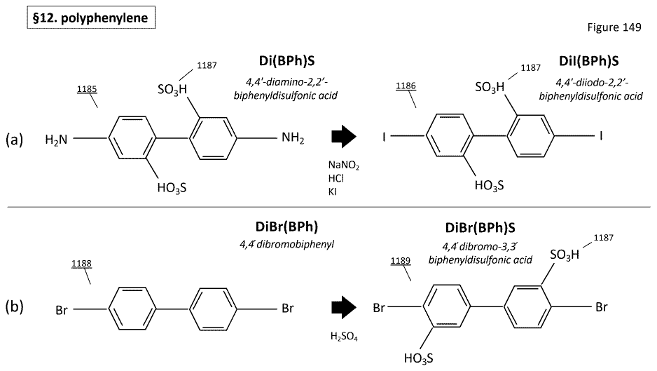

In another variant, FIG. 145 illustrates a branched polyphenylene matrix 1080b with a specified degree of branching DB and sulfonic acid groups 1181 with radical R 1182. In the example shown R comprises a (0+1)N moiety 1185b in branched polyphenylene polymers containing sterically hindered pyridines. Functionalizing a phenylated polyphenylene (PhPPh) heteropolymer 1180p with sulfonic groups 1181v using a Diels-Alder process is depicted in FIG. 146 resulting in sulfonated Diels-Alder polyphenylene (sDAPPh) 1180v. An alternative process shown in FIG. 147 employs tetra(para-sulfonated) triethylammonium bistetracyclone salt (TEAsBTC) 1179 treated sequentially by (a) PhNO₂, (b) 2M NaOH, and (c) 0.5M H₂SO₄ at 180° C. to form sulfonated hydrated phenylated polyphenylene (sPhPPh-H⁺) 1180w with ionomers 1181w.

FIG. 148 comprises a process flow for synthesis for hydroxylation of sulfonated phenylated polyphenylene (sPhPPh-H⁺) 980c into hydroxylated sulfonated-phenylated polyphenylene (sPhPPh-OH) 982z. FIG. 149 depicts various processes for synthesizing biphenyldisulfonic acid. The method of step (a) involves diazotization of 4,4′-diamino-2,2′-biphenyldisulfonic acid (Di(BPh)S) 1185 into 4,4′-diiodo-2,2′-biphenyldisulfonic acid (Dil(BPh)S) 1186 by treatment with treated with sodium nitrate (NaNO₂), hydrochloric acid (HCl), and potassium iodide (KI), a polyphenylene precursor with iodide terminus and sulfonic ionomers 1187. Sulfonic acid ionomer 1187 remains unchanged in both reactant and product chemistries.

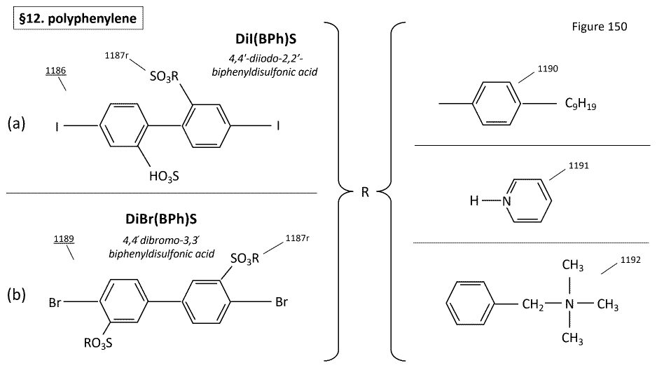

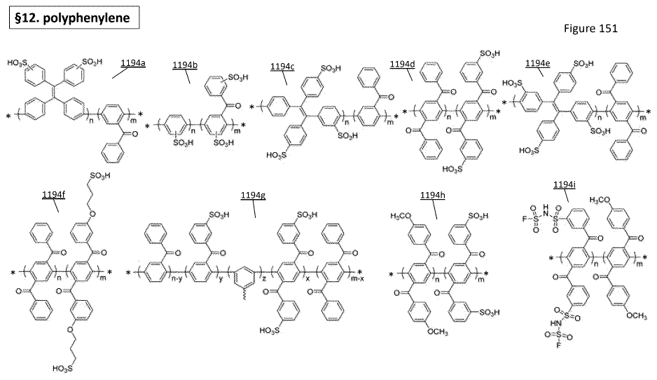

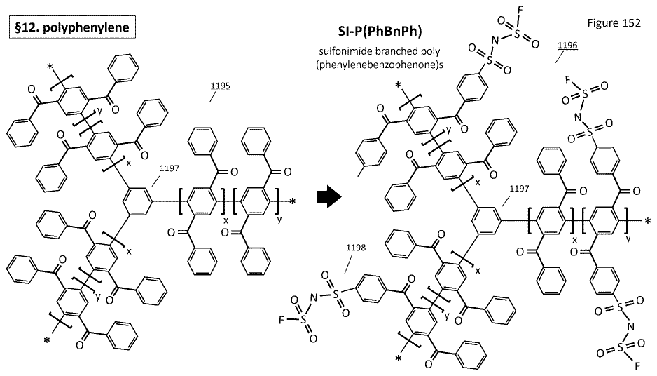

In an alternative method of case (b) the process involves halogenation of un-sulfonated reactant 4,4′dibromobiphenyl (DiBr(BPh)) 1288 into 4,4′dibromo-3,3′biphenyldisulfonic acid (DiBr(BPh)S) 1189 during which sulfonic ionomer 1187 is attached to the polymer. In FIG. 150 sulfonic ionomers 1187 present on either (Di(BPh)S) 1186 or (DiBr(BPh)) 1288 is reacted to replace hydrogen with radicals 1189, 1191, or 1192 forming ionomer SO₃R 1187t. FIG. 151 comprises other variations in sulfonated polyphenylene sidechains.

FIG. 152 depicts yet another process for synthesis of sulfonimide branched poly(phenylenebenzophenone)s (SI-P(PhBnPn)) polymer 1196 from a Y-configured branched phenyl compound 1995 with phenyl sidechains.

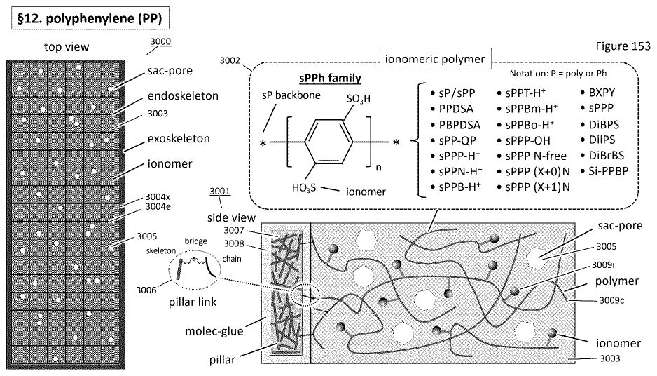

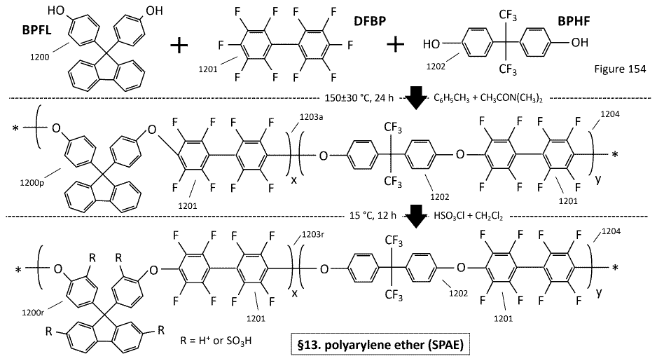

In summary, membrane top view 3000 and membrane side view 3001 in FIG. 153 illustrate a variety of elements of polyphenylene (PPh) ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler;
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the thermoplastic heteropolymer polyphenylene (PP) as a mainchain optionally blended or cross-linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid groups —SO₃H including variants sP, sPP, PPDSA, sPP-QP, sPPP-H⁺, sPPN-H⁺, sPPB-H⁺, sPPT-H⁺, sPPBm-H⁺, sPPBo-H⁺, sPPP-OH, sPPP N-free, sPPP (X+0)N, sPPP (X+1)N, BXPY, sPPP, DiBPS, DiPS, DiBrBS, and Si-PPBP; using the abbreviated acronyms where P may denote poly or phenyl;
where ionomeric polymer 3002 may also comprise carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte. and finally
where the combination of the endoskeletal pillars and the membrane coating are used to seal in any ionic liquid doping to prevent seepage, leakage, or IL depletion.

The following table describes the composition of various inventive polyphenylene IEMs:

| ionomer | structure | endoskeleton | solvents, X-L | fillers |
|---|---|---|---|---|
| §12. functionalized | heterogenous | polymers: PPh, | solv: CDM, PVDF, | sac filler, CNTs, |
| polyphenylene | PPh polymer | EPX, PUA, SIA, MAA | DMF, PEG, NMP, | oxides, POSS, |
| PPhDSA, PBPhDSA | | pillars: reinforcing | DMAc, ethanol, | NPs, MOFs, PIL |
| sPPh (linear, sidechain, | | fillers | glycol, glycerol, | |
| kinked) | | | aliphatic polyols, | |
| sPPh-benzoyl | | | MI | |
| sPPh-phenoxybenzoyl | | | X-L: heat, sulfur, | |
| SDAPP (Diels Alder) | | | peroxide, metal | |
| un-sulfonated PPh-R | | | oxides, S donors | |
| sPPh-BXPY | | | | |
| sidechain SC-sP(BnPh) | | | | |
| sidechain SC-sP(PhBnPh) | | | | |
| sPPh-QPh/sPhPPh-R | | | | |
| +radical R = H⁺(TPh) | | | | |
| +radical R = H⁺(BPh)ₚ | | | | |
| +radical R = H⁺(BPh)ₘ | | | | |
| +radical R = H⁺(BPh)ₒ | | | | |
| sPhPPh-(DB)H⁺ | | | | |
| sDAPPh, sPhPPh-H⁺ | | | | |
| sPhPPh-OH | | | | |
| Di(BPh)S-R, DiBr(BPh)S-R | | | | |
| sPPh-(X + Y)N sterically | | | | |
| hindered | | | | |
| SI-P(PhBnPh) | | | | |

As listed, polyphenylene (PPh) membranes made in accordance with this invention comprise an expansive list of compounds comprising heterogenous ionomeric polymers. Aside from bonding with itself, PPh can bond with a variety of endoskeletal materials including epoxy resins (EPX), polyurethane adhesives (PUA) especially post surface preparation, silicone adhesives (SiA), and modified acrylic adhesives (MAA). PPh solvents include dichloromethane (CDM), polyvinyl difluoride (PVDF), dimethylformamide (DMF), polyethylene glycol (PEG, PEO), N-methylpyrrolidone (NMP), N,N-dimethylacetamide (DMAc), ethanol, glycol, glycerol, aliphatic polyols, and diiodomethane (methylene iodide, MI). Cross linking occurs with heating, sulfur, peroxides, metal oxides, and with sulfur donors. Membrane fillers and dopants were described previously and for brevity's sake, will not be repeated here.

### § 13. Functionalized Polyarylene Ether (PAE) Polymer IEMs.

Another class of hydrocarbon based membranes comprise fluorine-free compounds made of the homopolymer polyarylene ether, a high performance thermoplastic with high glass transition temperatures noted for its robust mechanical properties, exceptional thermal stability, and superior chemical resistance. Conventional uses for PAEs include water purification, electrolysis, and ion exchange. PAEs comprise a mainchain featuring alternating rigid aromatic rings and flexible ether bonds, facilitating its high temperature performance and resilience to acid and alkali corrosion, solvent resistance, and oxidative stability. PAE membranes can also be further multi-functionalized to resist contamination from metal ions, microorganisms, bacteria, and other pollutants.

They may be subcategorized by their different functional groups, namely poly(arylene ether sulfone) (PAES, PAESf) containing sulfone segments in the mainchain; poly(arylene ether ketone) (PAEK) containing ketone segments in the mainchain; and poly(arylene ether nitrile) (PAEN) bonding cyano groups on its sidechain. PAEs are chemically related to polyether ether ketones (PEEK), polyethersulfones (PESf), and poly(arylene ether nitrile)s (PEN) considered elsewhere in this application.

FIG. 154 comprises one representative process flow for synthesis of the heteropolymer polyarylene ether (SPAE) from 4,4′(hexafluoroisopropylidene) diphenol (BPHF) 1202, 4,4′-(9-fluorenylidene) diphenol (BPFL) 1200, and decafluorobiphenyl (DFBP) 1202. Blended with C₆H₅CH₃ and CH₃CON(CH₃)₂ the reactants were polymerized at 150° C. into a mainchain comprising two segments—segment 1203a of length x comprising BPFL 1200p and DFBP 1201, and segment 1204 of length y containing BPHF 1202 and DFBP 1201. BPFL 1200p differs from its precursor BPFL 1200 only by polymerization and by conversion of OH groups into bound oxygen.

During subsequent functionalization with a radical R of hydrogen ions H⁺ or sulfonic acid SO₃H, segment 1203 is transformed into equal length 1203r by converting BPFL 1200p into radical functionalized group 1200r by attaching the acidic groups onto the aromatic rings. All other groups remain unchanged. The functionalization may be performed in a number of ways, one of which involves sulfonation using a 12 h treatment at 15° C. in HSO₃Cl and CH₂Cl₂ while incorporating phosphotungstic acid and graphene oxide to enhance conductivity.

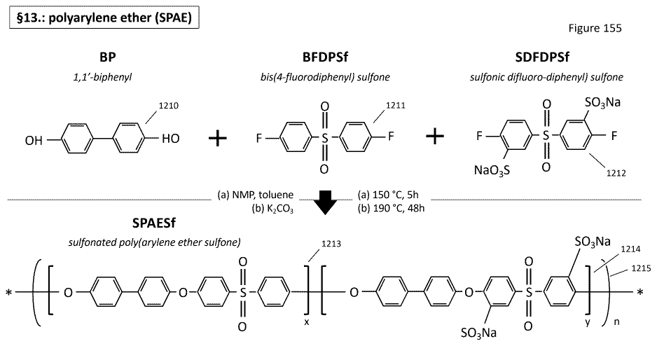

Alternatively various monomers can be polymerized into a sulfonated polyarylene ether sulfone (SPAES) using processes composite membranes containing poly(2,5-benzimidazole)-grafted graphene oxide. Specifically, FIG. 155 comprises process flow for synthesis of the heteropolymer sulfonated polyarylene ether (SPAES) from 4,40-difluorodiphenyl (BFDPS) 1211; 4,4-dihydroxybiphenyl (BP) 1210; and 3,30-disulfonated-4,40-difluorodiphenyl sulfone (SDFDPS) 1212. Processing of the reactants requires the application of N-methyl-2-pyrrolidone (NMP) and toluene at 150° C. for 5 h in step (a), followed by K₂CO₃ for 48 h at 190° C. in step (b). The resulting sulfonated polyarylene ether sulfone (SPAES) comprises two identical moieties—a non-functionalized segment 1213 of length x and a sulfonated component 1214 comprising ionomers SO₃X of length t where the combined length 1215 of (x+y) is repeated n times.

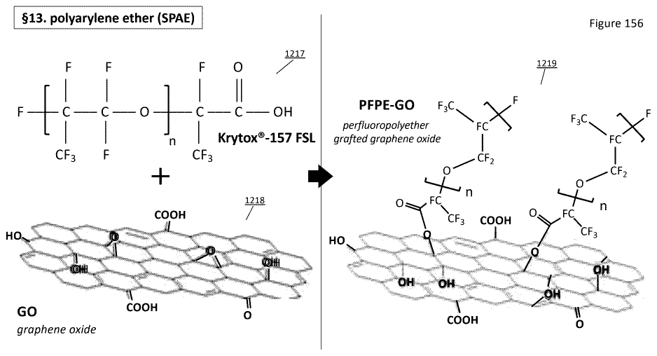

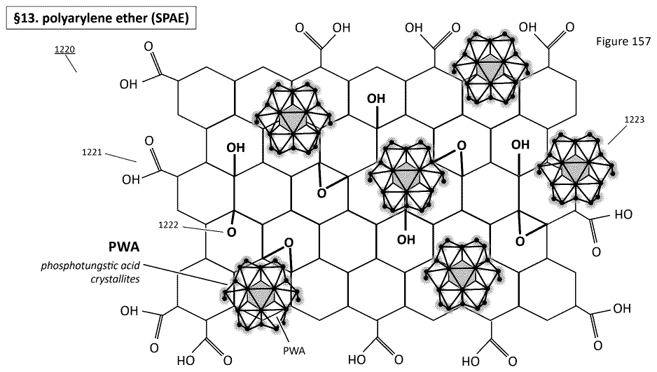

FIG. 156 comprises the process flow for synthesis of the heteropolymer sulfonated polyarylene ether (SPAES) perfluoropolyether grafted graphene oxide (PFPE-GO) 1219 from graphene oxide (GO) 1218 and fluorinated surfactant Krytox®-157 FSL 1212. Synthesis of PFPE-GO involves the treatment of graphene oxide by surfactants such as Krytox®-157 FSL comprising a terminal fluoromethylene group of poly(hexafluoropropylene oxide) to enable grafting of fluorocarbon pendants onto GO substrate 1219. As such, the sidechain includes both terminal fluorine and a hydroxide terminus for GO bonding forming PFPE-GO 1219. For example a sulfonated poly(arylene ether sulfone) polymer may form a composite hybrid membrane with perfluorosulfonic acid and doped with perfluoropolyether (PFPE) grafted graphene oxide (GO) to enhance conduction.

Alternatively FIG. 157 comprises the chemical structural depiction of exemplary heteropolymer sulfonated polyarylene ether (SPAESf) incorporating phosphotungstic acid (PWA) into crystalline clusters 1223 bonded to graphene oxide (GO) substrate 1220. Dangling bonds comprise HO₂ 1221 and O 1222 enabling the SPAESf to facilitate bonding to other polymers in a membrane.

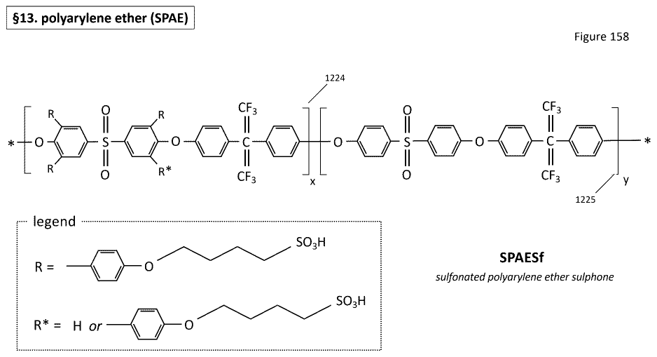

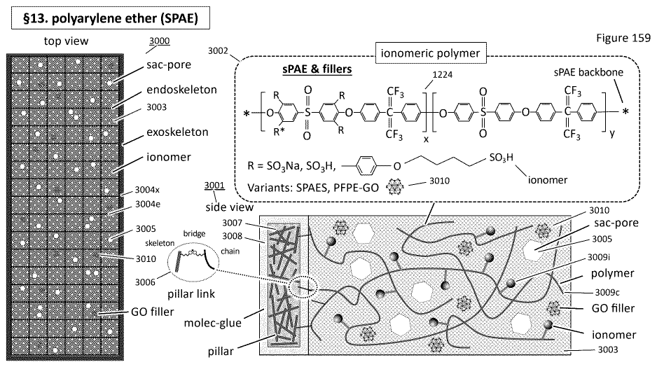

FIG. 158 is a chemical representation of sulfonated polyarylene ether sulphone (sPAES) illustrating the polymer mainchain contains two segments. In segment 1225 of length y includes the linear copolymer of a sulfone and hexafluoroisopropylidene diphenol with no ionomeric functionalization. Segment 1224 by contrast contains a functionalized sulfone segment with radical R attached to available sites on its aromatic rings, where the radical R may comprise a hydrogen ion (H⁺) or phenyl-bound sulfonic acid (SO₃H) group.

In summary, membrane top view 3000 and membrane side view 3001 in FIG. 159 illustrate a variety of elements of ionomeric polymer 3002 of polyarylene ether (PAE) compounds made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the thermoplastic heteropolymer polyarylene ether (PAE) as a mainchain 1224 optionally blended or cross-linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers including perfluoropolyether (PFPE) grafted graphene oxide 3010;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte and finally
where the combination of the endoskeletal pillars and the membrane coating are used to seal in any ionic liquid doping to prevent seepage, leakage, or IL depletion.

The following table describes various structural elements of the SPAE class of membranes:

| ionomer | structure | endoskeleton | solvents, X-L | fillers |
|---|---|---|---|---|
| §13. sulfonated poly | heterogenous | polymers: PAE, PS, HIPS, | solv: NMP, DMAc, | sac filler, CNTs, |
| (arylene ether)s | PAE polymers | PAm, PEs, PU, ABS, | DMSO, DMF, PEG, | oxides, POSS, |
| sPAE | | pillars; reinforcing fillers | DGMME | NPs, MOFs, PIL, |
| sPFPE | | (C-fiber, CNTs) | X-L: DT, SDT, PFPE | PFPE-GO |
| sPAESf | | | | |

The various sulfonated polyarylene ethers comprise heterogenous polymers of non-fluorinated sPAE, fluorinated sPFPE, and sulphone based sPAES. Endoskeletal materials compatible with bonding to PAEs include polystyrene (PS) and high-impact polystyrene (HIPS) which share the styrene moiety in the backbone of poly(arylene ether)s; polyamides (PAm, nylon) using appropriate adhesives or surface treatments; polyesters (PEs) using compatibilizers or coupling agents containing carboxyl or anhydride groups to enhance interfacial adhesion; polyurethanes (PU) using adhesives or by interpenetrating polymer networks (IPNs) by synthesizing PU in the presence of PAE; and acrylonitrile butadiene styrene (ABS). Solvents for s(PAE)s include N-methylpyrrolidone (NMP), N,N-dimethylacetamide (DMAc), dimethylsulfoxide (DMSO), dimethylformamide (DMF), polyethylene glycol (PEG, PEO), and diethylene glycol monomethyl ether (DGMME). Cross linkers include dithiol (DT), sulfonated dithiol (SDT), and bishydroxy perfluoropolyether (PFPE). Aside from PFPE-GO crystallites described in the section, membrane fillers and dopants described previously have been omitted for the sake of brevity, and will not be repeated here.

### § 14. Functionalized Poly Ether Ketone (PEK) Polymer IEMs.

A special category of polyarylene ether is a class of non-fluorinated thermoplastics heteropolymers referred to as polyether ketones. Collectively referred to as PEK or PEEK these polyether ketones contain any number of ether and ketone groups assembled on a polymer mainchain in varying stoichiometries and sequences. Polyether ketones (PEKs) including polyether ether ketone (PEEK) are formed by the dialkylation of bisphenolate salts, i.e. a process that adds two alkene groups onto the phenylated salt using step-growth polymerization.

Constructed by a linear polymeric chain of covalently bonded phenyl groups, the resulting semicrystalline matrix exhibits superior mechanical properties and chemical resistance even at elevated temperatures. Aside from mechanical applications of plastics, polyester ketones have chemical applications membrane such as solid polymer electrolysis (SPE) and as proton exchange membranes in fuel cells.

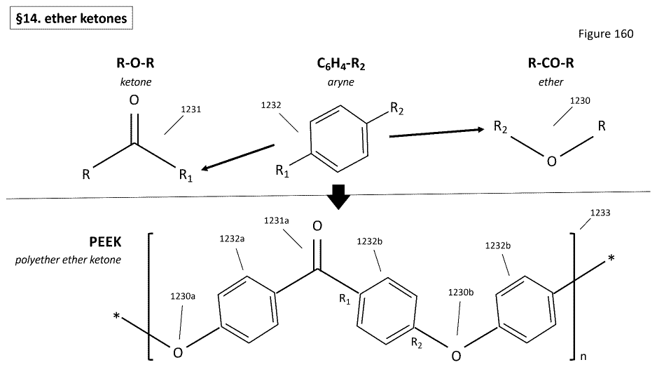

The basic process for forming a polyether ketone is illustrated in FIG. 160 where three organic components comprising ketone 1231, an aromatic hydrocarbon ring referred to as aryne group 1232, and ether group 1230 are polymerized into polyether ether ketone (PEEK) 1233. These constituent reactants are manifest in the chemical PEEK product. As a matter of definition, a ketone group comprises a carbon-oxygen double bond (C═O) is bound to two radical groups R while an ether group comprises a carbon-oxygen single bond (C—O) also bound two radical groups R. Chemically as C₆H₄—R₂, an aryne group comprise an aromatic ring bond to two radicals R. PEEK 1233 as depicted comprises three aryne groups 1232a-to-1232c, ether groups 1230a and 1230b, and ketone group 1231a. In polyether ketone heterogenous polymers, the aryne group serves as the bridge between the ketone and ether groups. Specifically aryne 1232b serves as radical R₁ for ketone 1231a and as radical R₂ for ether 1232b together forming the polyether ketone mainchain. Clarification on the somewhat confusing naming conventions for ether-ketone molecules are described in the online website victrex.com.

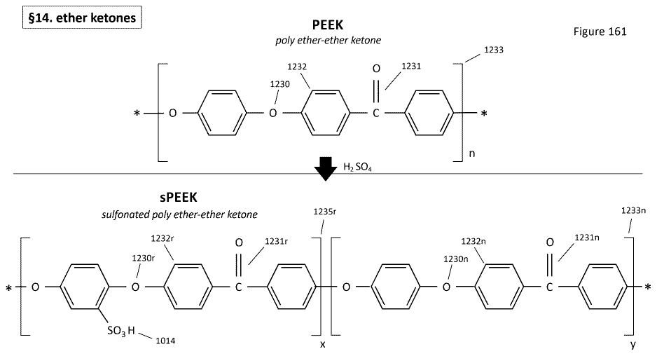

Although nascent poly ether ketones are electrical insulators, the polymers area readily functionalized by sulfonic groups to become proton specific ionomeric conductors. FIG. 161 illustrates sulfonating poly ether-ether ketone (PEEK) with hydrosulfuric acid H₂SO₄, the process converting the homopolymer PEEK 1233 into a heteropolymer comprising a non-sulfonated chain segment 1233n of length y with ether group 1230n, ketone group 1231n, and aromatic ring aryne 1232n; and with sulfonated chain segment 1233r of length x with ether group 1230r, ketone group 1231r, and aromatic ring aryne 1232r; and with sulfonic acid 2014 attached to one of the aromatic rings in the sulfonated chain segment 1233r. In some instances nanosulfonated silica may be blended into a SPEEK/SPVDF-HFP to enhance its conductivity.

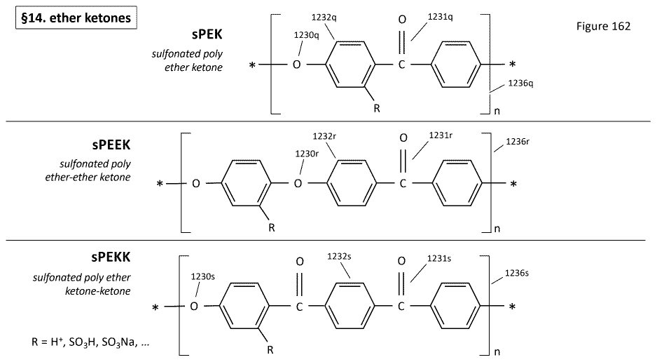

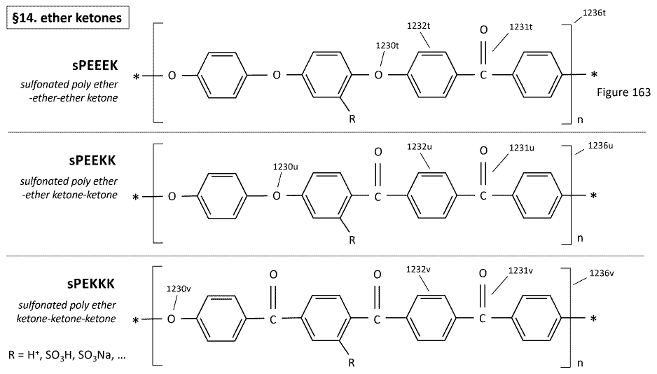

FIG. 162 illustrates various moieties of polyether ketone molecules depending on the synthesis sequences employed. For example in 1998 research at Virginia Tech, aromatic polyketones were fabricated from soluble precursors derived from bis(a-amininitrile)s. Other organic precursors may also be employed resulting in PEK molecular variants. In exemplary moieties, sulfonated polyether ketone (sPEK) 1236q comprises a single ether 1230q, a single ketone 1231q, and two aryne groups 1232q, one functionalized by radical R where radical R may comprise a hydrogen ion H⁺, sulfonic acid SO₃H, or sodium sulfite NaSO₃. Sulfonated polyether ether ketone (sPEEK) 1236r, shown previously as sulfonated segment of heteropolymer sPEEK 1235r in FIG. 161, comprises a two ethers 1230r, a single ketone 1231r, and three aryne groups 1232q, one which is functionalized by radical R. Sulfonated polyether ketone-ketone (sPEKK) 1236s comprises one ether 1230s, two ketones 1231s, and three aryne groups 1232s, one which is functionalized by radical R.

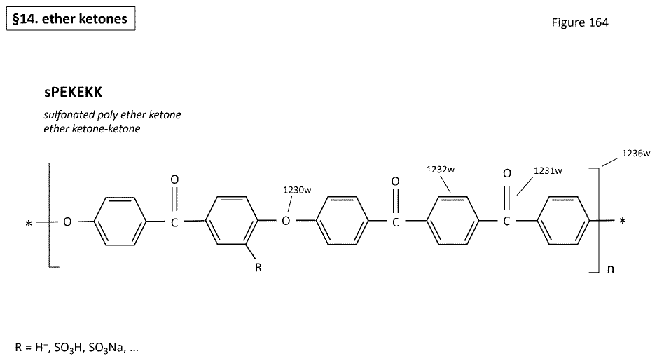

FIG. 163 illustrates sulfonated polyether ether-ether ketone (SPEEEK) 1236t comprising three ethers 1230t, one ketone 1231t, and four aryne groups 1232t, one which is functionalized by radical R. Sulfonated polyether ether ketone-ketone (SPEEKK) 1236u comprises two ethers 1230u, two ketones 1231u, and four aryne groups 1232u, one which is functionalized by radical R. In another variant, sulfonated polyether ketone-ketone-ketone (SPEKKK) 1236v comprises one ether 1230v, three ketones 1231v, and four aryne groups 1232v, one which is functionalized by radical R. In yet another variant, FIG. 164 illustrates sulfonated polyether ketone ether ketone-ketone (sPEKEKK) 1236w comprising two ethers 1230w, three ketones 1231w, and five aryne groups 1232w, one which is functionalized by radical R.

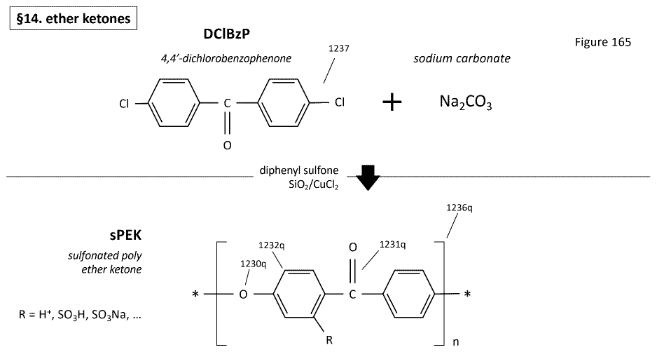

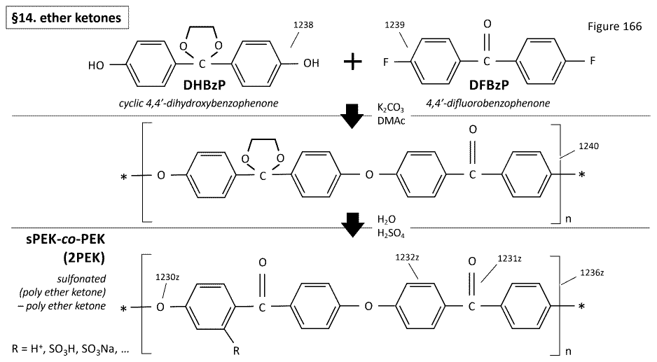

FIG. 165 illustrates the polymerization of 4,4′-dichlorobenzophenone (C₁₃H₈Cl₂O, DBP-Cl, DClBzP) 1237 with sodium carbonate (Na₂CO₃, washing soda) catalyzed by diphenyl sulfone and SiO₂—CuCl₂ to produce sulfonated poly ether ketone (sPEK) 1236q comprising one ether 1230q, one ketone 1231q, and two aryne groups 1232q, the same polymer as depicted in FIG. 162.

FIG. 166 illustrates the polymerization of reactants cyclic 4,4′-dihydroxybenzophenone (DBP-H, DHBzP) 1238 and 4,4′-difluorobenzophenone (DBP-F, DFBzP) 1239 with dimethylacetamide (DMAc) and potassium carbonate (K₂CO₃) to produce a non-conductive intermediary polymer 1240. Polymer 1240 is subsequently functionalized by diluted H₂SO₄ to produce a sulfonated (poly ether ketone)-co-(poly ether ketone) (sPEK-co-PEK, 2PEK) polymer 1236z. As shown, the heterogenous polymer 1236z comprises two ether groups 1230z, two ketone groups 1231z, and four aryne groups 1232z.

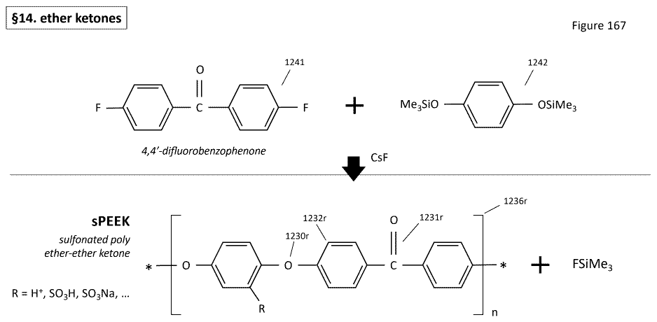

FIG. 167 illustrates one method to fabricate sulfonated polyether ether ketone (sPEEK) 1236r by combining 4,4′-difluorobenzophenone 1241 with phenylated trimethylsulfonium (Me₃SO)Bn 1242 in the presence of cesium fluoride (CsF). As described previously, sulfonated polyether ether ketone (sPEEK) 1236r is a heterogenous polymer comprising two ether groups 1230r, one ketone 1231r, and three aryne groups 1232r.

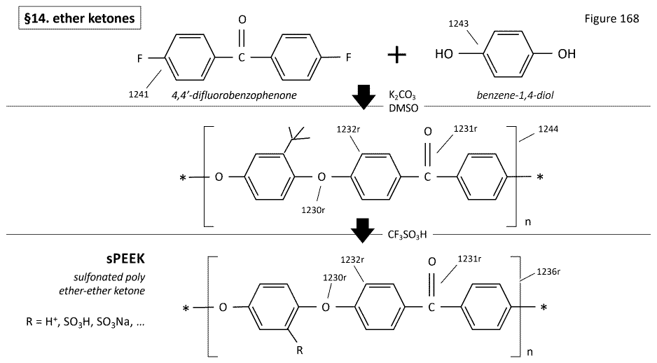

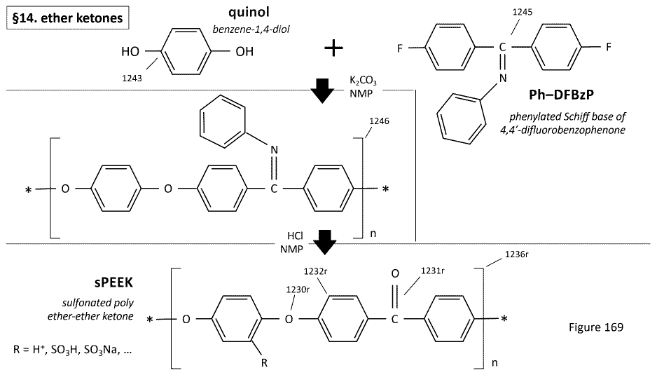

FIG. 168 illustrates an alternate process for forming sulfonated polyether ether ketone (sPEEK) 1236r by combining reactants 4,4′-difluorobenzophenone 1241 and benzene-1,4-diol (hydroquinone) 1243 together with reagents dimethyl sulfoxide (DMSO, (CH₃)₂SO) and potassium carbonate (K₂CO₃) to produce a non-conductive intermediary polymer 1244. The intermediary is then converted into an ionomer by treatment in triflic acid (TFSA, CF₃SO₃H). As described previously, the chemical product sulfonated polyether ether ketone (sPEEK) 1236r is a heterogenous polymer comprising two ether groups 1230r, one ketone 1231r, and three aryne groups 1232r.

FIG. 169 illustrates yet another process for forming sulfonated polyether ether ketone (sPEEK) 1236r by combining reactants benzene-1,4-diol (quinol, hydroquinone) 1243 and phenylated Schiff base of 4,4′-difluorobenzophenone (Ph-DFBzP) together with reagents potassium carbonate (K₂CO₃) and N-methyl-2-pyrrolidone (NMP) to form intermediary moiety 1246, a SPEEK precursor. Subsequent treatment in hydrochloric acid (HCL) and N-methyl-2-pyrrolidone (NMP) produces sulfonated polyether ether ketone (sPEEK) 1236r comprising two ether groups 1230r, one ketone 1231r, and three aryne groups 1232r.

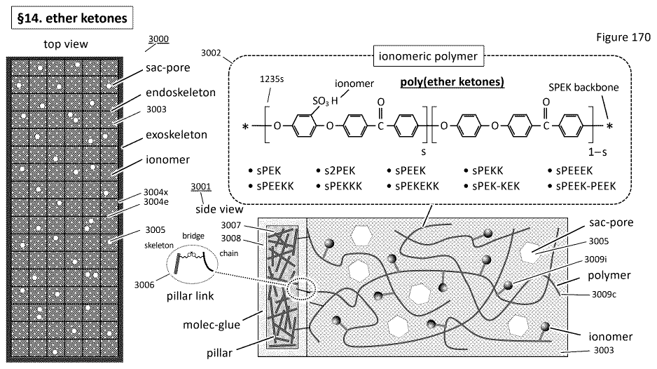

Membrane top view 3000 and membrane side view 3001 in FIG. 170 illustrate a variety of elements of ionomeric polymer 3002 comprising polyether ketone complexes made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the thermoplastic heteropolymer in the class of poly(ether ketones) 1235s as a mainchain including sulfonated polymers sPEK, s2PEK, s(iPEK), sPEEK, s(iPEEK), s(iPEKK), s(iPEEKK), s(iPEEEK), or s(iPEKEKK); optionally blended or cross-linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers (not shown);
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table describes various structural elements of the PEK and PEEK class of membranes:

| ionomer | structure | endoskeleton | solvents, X-L | fillers |
|---|---|---|---|---|
| §14. sulfonated poly | heterogenous | polymers: PEK, PEEK, | solv. HNO₃, HF | sac filler, CNTs, |
| (ether-ketone)s | PEEK polymer | PEI, PAI, PAm, PPhS, PU, | H₂SO₄, ClPh, DCM, | oxides, POSS, |
| sPEK, sPEKK | | EPX, adhesives (silicone, | C₁₃H₈O, THF, ace | NPs, MOFs, PIL |
| sPEEK | | cyanoacrylates), PTFE | X-L: AlCl₃-DCE | |
| sPEEK-PEEK | | pillars: reinforcing fillers | K₂CO₃-DCE, HQu, | |
| sPEEEK, sPEEKK | | (C-fiber, CNTs) | PhOBnCl-DMAc | |
| sPEKKK, sPEKEKK | | | | |
| sPEK-PEK (s2PEK) | | | | |

The prior table describes the construction of various polyether ether ketone IEMs made in accordance with this invention. Comprising various combinations of ether and ketone groups, the family of heterogenous polymers collectively referred to as PEK or PEEK, may include one-to-three ether groups and one-to-three ketone groups in varying numbers and sequences. Endoskeletal compositions compatible with bonding to polymeric blends of ethers and ketones may include polyetherimide (PEI), polyamide-imide (PAI), and polyphenylene sulfide (PPhS) using high temperature or interlocking adhesives; epoxy resins (EPX); polyurethanes (PU) and cyanoacrylates for lower temperature operation; and with proper pretreatment of the endoskeletal pillars with adhesives comprising silicone and modified acrylics.

Composite reinforced poly ether ketone membranes blended with polytetrafluoroethylene (PEEK-PTFE) may also bond to PTFE pillars. Alternatively, glues may be used to attach poly ether-ketone based membranes to poly ether-ketone pillars. such as PEK and PEEK. All PEK-PEEK family polymers can be functionalized by sulphonic acid, as denoted by a lowercase prefix ‘s’ whereby sulfonated PEK is denoted as sPEK, sulfonated PEEK is denoted as sPEEK, etc.

Solvents may include nitric acid (HNO₃), sulfuric acid (H₂SO₄), hydrofluoric acid (HF), 4-chlorophenol (C₆H₅ClO, ClPh), 9-fluorenone (C₁₃H₈O), methylene chloride (DCM), tetrahydrofuran (THF, oxolane), acetone (ace), and hexafluoroisopropyll (HFIP). Cross linking agents of poly ester ketone compounds include sodium borohydride (NaBH), bis(hydroxymethyl) (CH₃O). Polymerization agents and catalysts include aluminum chloride in dichloroethane (AlCl₃-DCE) and 4-phenoxybenzoyl chloride (PhOBnCl, C₁₃H₉ClO₂) in N,N-dimethylacetamide (DMAc, C₄H₉NO), hydroquinone (HQu, C₆H₆O₂). Membrane fillers and dopants were described previously and for brevity's sake, will not be repeated here.

### § 15. Functionalized Poly Ether-Sulfone/Ketone-Sulfone Polymer IEMs.

Another related class of heteropolymers is that of polyether sulfones and poly ketone sulfones. This group includes sulfones combined with ether such as polyether ether sulfone (PEES, PEESf); sulfones combined with ketones such as polyketone ketone sulfone (PKKS, PEESf), or sulfones combined with both ethers and ketones such as poly(arylene ketone ether ketone sulfone) (PAKEKS, PAKEKSf). All poly ether/ketone sulfone moieties including PEESf, PKKSf, and PAKEKSf contain aromatic hydrocarbon rings, i.e. benzene rings. Somewhat confusingly, these aromatic groups are explicitly named in some polymers while the name of other polymers neglects to mention their presence. Moreover, when explicitly identified in a polymer's common chemical name, these aromatic rings may be referred to as arylene, aryne, phenyl, or phenylene depending on its bonding and oxidation states.

In contrast to § 14 describing various combinations of ethers and ketones, polymers described in this section all contain a sulfone group, which may be abbreviated as either ‘S’ or ‘Sf’. The abbreviation ‘S’ is ambiguous and must be taken in context of the polymer containing it. Other ‘S’ can be mistakenly confused with the symbol for elemental sulfur. Accordingly, sulfone (S, Sf) is an organosulfur compound having the form R—S(═O)₂—R where both oxygen atoms form double bonds to the central sulfur atom. As described, sulfone polymer radicals may comprise an ether group, a ketone, group, or an aromatic hydrocarbon ring. In polymers, sulfones confer numerous beneficial material properties including mechanical strength and resistance to oxidation, corrosion, high temperatures, and creep under stress. Direct comparison between ketone and sulfone groups shows no discernable difference or advantage of one over the other in proton exchange membranes.

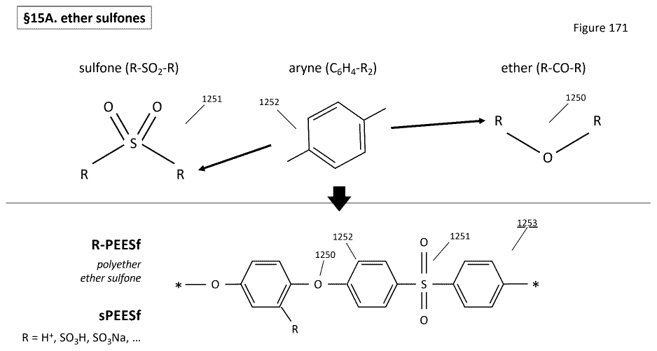

In the case of polyether sulfones such as polyether ether sulfone (PEES, PEESf) 1253 described in section § 15 A shown in FIG. 171, three functional groups, namely sulfone (R—SO₂—R) 1251, aryne (C₆H₄—R₂) 1252, and ether (R—CO—R) 1250 are involved in its synthesis. Similar to the poly ether ketones, radicals R of poly ether sulfones may comprise a hydrogen ion H⁺, sulfonic acid SO₃H, sodium sulfite NaSO₃, or other ionomeric molecules.

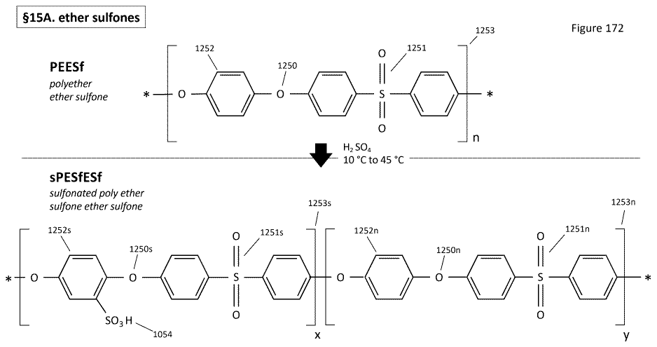

FIG. 172 illustrates the functionalization of polyether ether sulfone (PEESf, PEES) 1253, an electrical insulating polymer, by the application of sulfuric acid (H₂SO₄) resulting in sulfonated polyether ether sulfone (sPEESf, sPEES) 1253s. This sulfonation process converts PEESf 1253, a homopolymer, into a heteropolymer comprising a un-sulfonated segment 1253n including two ether groups 1250n, a single sulfone group 1251n, and two aromatic rings 1252n into a sulfonated ionomeric segment 1253s containing two ether group 1250s, a single sulfone group 1251s, and a two aromatic rings 1252s with attached SO₃H sulfonic acid ionomer 1054. Various publications consider the formation of sulfonated poly(ether-ether ketone) and sulfonated poly(1,4-phenylene ether-ether sulfone) membranes for use as battery separator films vanadium redox flow batteries. Although they lack the intrinsic characteristics important in fuel cell ionomers, the basic PEESf polymer backbone synthesis is adaptable with suitable changes.

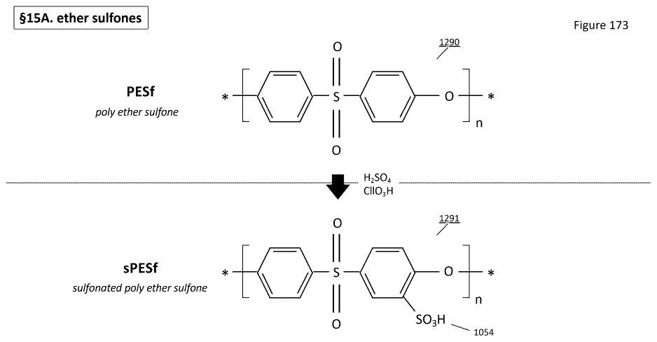

FIG. 173 illustrates a similar process for sulfonating a single-ether polyether sulfone (PESf, PES) 1290 molecule by treatment in sulfuric acid (H₂SO₄) and chloric acid (ClIO₃H) to produce sulfonated poly ether sulfone (sPESf, sPES) 1291 by attaching sulfonic acid SO₃H 1054 onto one of the polymer's aromatic rings. In other efforts sulfonated polyether sulfone membranes were reinforced with bismuth-based organic and inorganic additives to enhance their structural integrity.

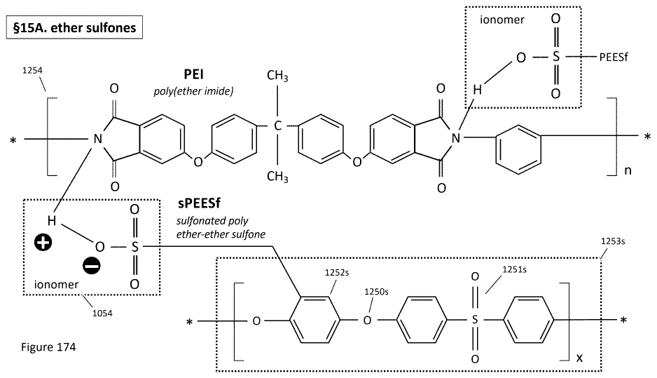

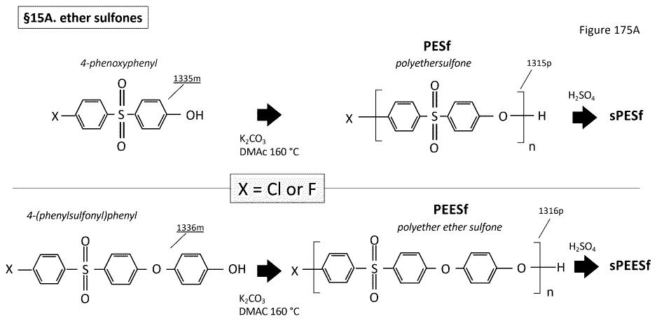

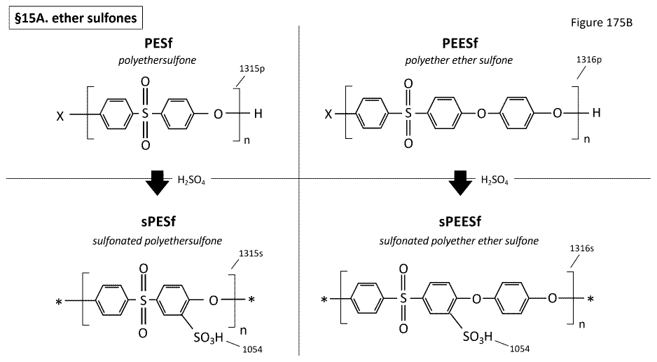

A PEESf mainchain can also form a copolymer with other polymer types such as poly(ether imide) (PEI) prospectively applicable in direct methanol fuel cells (DMFCs). As shown in FIG. 174, sulfonated polyether ether sulfone (sPEESf, sPEES) 1253s includes two esters 1250s, one ketone 1251s, and three aromatic rings 1252s, one of which attached to sulfonic acid group 1054. In addition to bonding to PEESf chain 1253s, sulfonic acid group 1054 forms a cross linking bond to poly ether imide (PEI) 1254 via a hydrogen bond to a reactive nitrogen in the PEI mainchain. Other nitrogen ions on PEI 1254 chain likewise may connect to other ionomers, in turn linking to other sPEESf chains creating a spider-web of interconnected polymer strands.

Various synthesis methods for forming poly(ether sulfone)s exist, some facile such as self-polycondensation of AB-type monomers. Other processes are more complex. For example, FIG. 175A the creation of unfunctionalized polyethersulfone (PESf, PES) 1315p starts with a chlorinated or fluorinated biphenyl monomer 4-phenoxyphenyl 1335m treated by potassium carbonate (K₂CO₃) and dimethylacetamide (DMAc) at 160° C. The same process can be used to convert the triphenyl monomer 4-(phenylsulfonyl)phenyl 1336m into unfunctionalized polyether ether sulfone (PEESf, PEES) 1316p. FIG. 175B illustrates the sulfonation of polyethersulfone (PESf) 1315p into sulfonated polyethersulfone (sPESf) 1315s including sulfonic acid 1054 as ionomer.

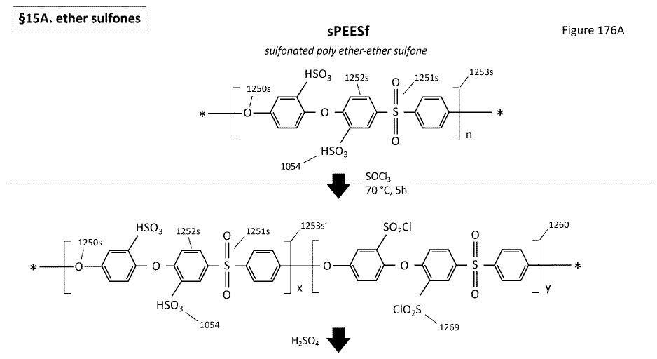

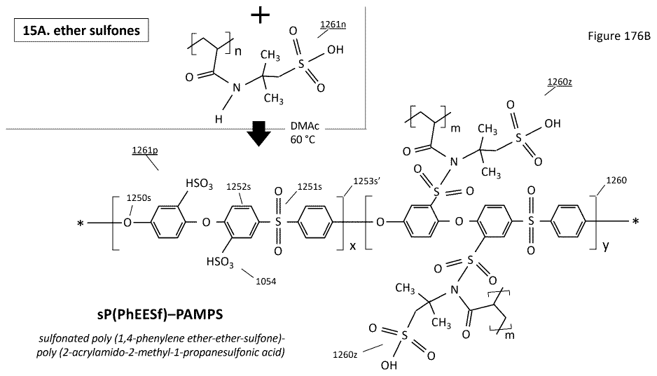

More complex copolymerization sequences involve two-step functionalization and cross linking as shown in FIG. 176A. Starting with a sulfonated polyether ether sulfone (sPEESf, sPEES) 1253s homopolymer comprising two ether groups 1250s, one ketone 1251s, and three aromatic rings 1252s and sulfonic group 1054, treatment by sulfur trichloride monoxide anion (SOCl₃) at 70° C. converts the homopolymer into a heteropolymer comprising a sulfonated segment 1253s′ and a chlorinated segment 1260. Sulfonated segment sPEES 1253s′ is identical to starting polymer 1253s in composition but shorter in length, reduced from length n to x. The newly chlorinated segment 1260 of length y is modified wherein sulfonic groups 1054 are replaced by sulfurochloridoite (ClO₂) groups 1269, where length y=(n−x).

Subsequent treatment in dimethylacetamide (DMAc) at 60° C. on un-fluorinated hydrocarbon 1261n shown in FIG. 176B results in heterogenous copolymer 1261p comprising sulfonic segment 1253s′ and modified polymer segment 1260 with pendants 1260z. Sulfonic segment 1252s′ is identical in composition but shorter in length than starting polymer 1253s, i.e. x<n. Conversely and modified polymer segment 1260 includes a substitution of sulfonic acid SO₃H radicals with another polymeric chain 1260z comprising poly(2-acrylamido-2-methyl-1-propanesulfonic acid).

The resulting heterogenous polymer 1261p has the chemical name sulfonated poly (1,4-phenylene ether-ether-sulfone)-poly (2-acrylamido-2-methyl-1-propanesulfonic acid) (sP(PhEESf)-PAMPS) where the abbreviation Ph refers to the phenylene group 1252s, Sf refers to the sulfone group 1251s, and S refers to sulfonic acid 1054. One prospective process to form such polymers involves the integration of intercalated poly (2-acrylamido-2-methyl-1-propanesulfonic acid) into sulfonated poly (1,4-phenylene ether-ether-sulfone). Other ether sulfone monomers combine different sulfone reactants to form a longer chain precursor.

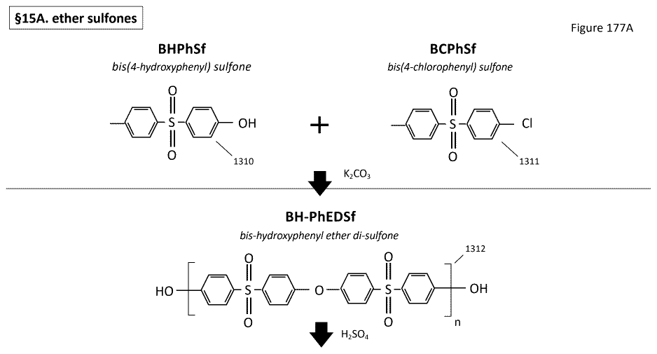

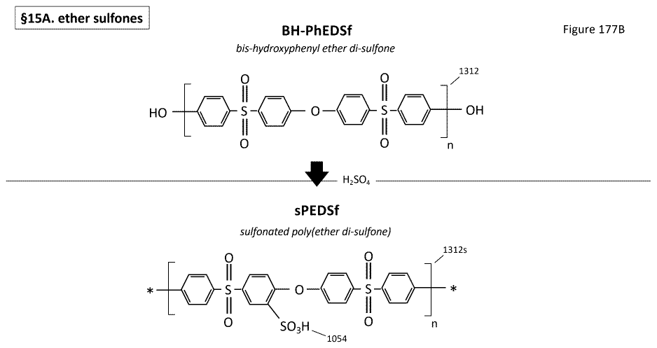

For example in FIG. 177A, reactants bis(4-hydroxyphenyl) sulfone (BHPSU, BHPSf, BHPS) 1310 and bis(4-chlorophenyl) sulfone (BCPSU, BCPSf, BCPS) 1311 are mixed and reacted with potassium carbonate (K₂CO₃) to produce the quarto-phenyl monomer bis-hydroxyphenyl ether sulfone (BHPESf, BHPES) 1312. Subsequent treatment in sulfuric acid (H₂SO₄) converts un-sulfonated polymer bis-hydroxyphenyl ether di-sulfone 1312 into sulfonated polymer bis-hydroxyphenyl ether di-sulfone (sPEDSf, sped) 1312s including sulfonic acid (SO₃H) 1054.

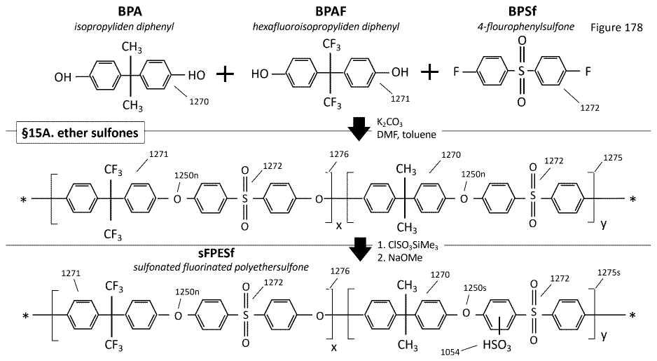

Another process for creating sulfonated fluorinated polyethersulfone is described in FIG. 178, where isopropyliden diphenyl (BPA) 1270, hexafluoroisopropyliden diphenyl (BPAF) 1271, and 4-flourophenylsulfone (BPSU, BPSf) 1272 are combined with potassium carbonate (K₂CO₃), dimethylformamide (DMF), and toluene to form intermediary polymer chain with segments 1275 and 1276, each fluorinated hydrocarbon compounds but of differing stoichiometric blends. Specifically segment 1275 of length y comprises one sulfone group 1272, one ether group 1250n, and one isopropyliden diphenyl group 1270 but no fluorocarbons. Slightly longer fluorinated segment 1276 of length x contains one sulfone group 1272, two ether groups 1250n, and one hexafluoroisopropyliden diphenyl group 1271. Despite the long length and numerous constituent moieties, the polymer is essentially non-conductive.

Subsequent treatment in chlorosulfuric acid-allylsilane (ClSO₃—SiMe₃) and sodium methoxide (NaOMe) attaches sulfonic acid (SO₃H) 1054 to one of the aromatic rings, converting polymer segment 1275 into an ionomeric polymer segment 1275s while leaving segment 1276 undisturbed. The resulting heterogenous polymer comprising ionomeric segment 1275s of length y and un-sulfonated segment 1276 of length x is referred to herein as sulfonated fluorinated polyethersulfone (sFPESf, sFPES). Such functionalized ionomers also referred to as partially-fluorinated polyethersulfone are in their present implementation applicable for high temperature membranes with minimal swelling, but limited in performance at room temperature.

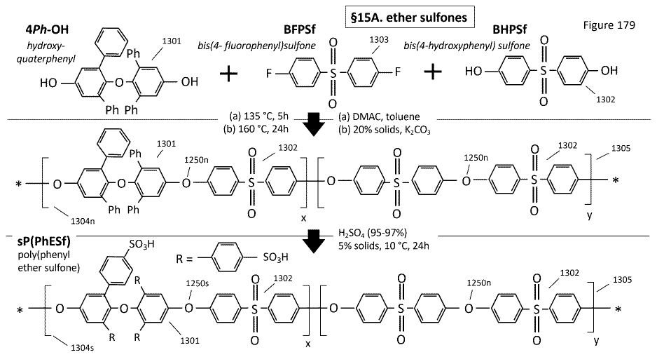

An alternative membrane synthesis technique shown in FIG. 179 combining hydroxy-quaterphenyl (4Ph-OH) group 1301 with bis(4-fluorophenyl)sulfone (BFPSU, BFPSf, BFPS) 1303 and bis(4-hydroxyphenyl) sulfone (BHPSU, BHPSf, BHPS) 1302 to produce a heterogenous polymer comprising two segments 1304n of length x and 1305 of length y.

As shown segment 1304n contains one hydroxy-quaterphenyl (4Ph-OH) group 1301, two esters 1250n, and one sulfone group 1302. In contrast, segment 1305 contains two sulfone groups 1302 and two ethers 1250n. Functionalization by concentrated sulfuric acid (96% H₂SO₄) converts the phenyl groups Ph in hydroxy-quaterphenyl group 1301 to radicals R where is a phenyl group with a sulfonic acid (SO₃H) ionomer. Since ionomeric radical R substitutes three phenyls, a significant change in the conductivity of segment 1304s is manifested. The resulting heterogenous polymer containing sulfonated segment 1304s and un-sulfonated segment 1305 is referred to herein as poly(phenyl ether sulfone) with the acronym sP(PhESf).

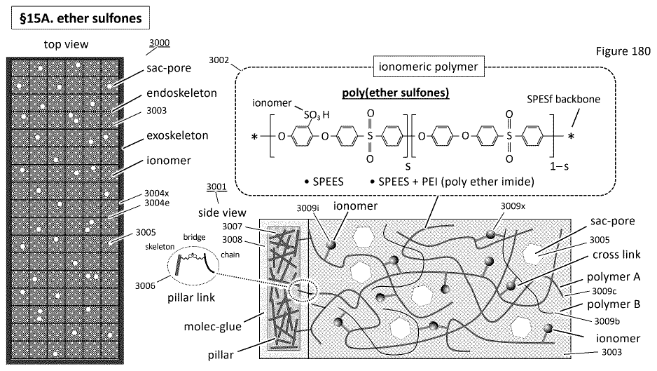

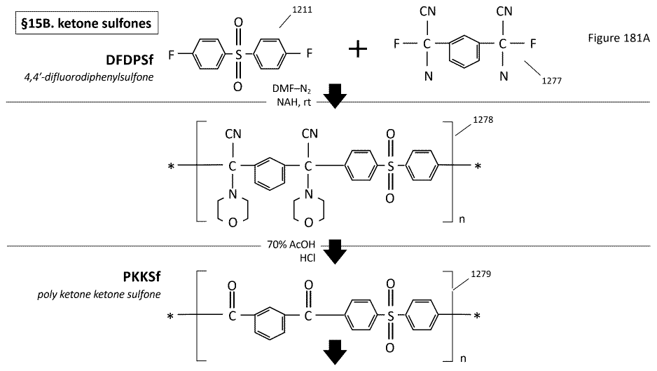

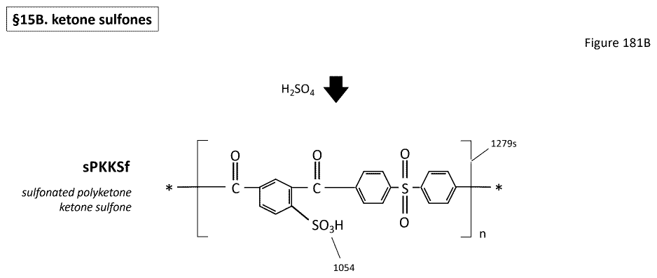

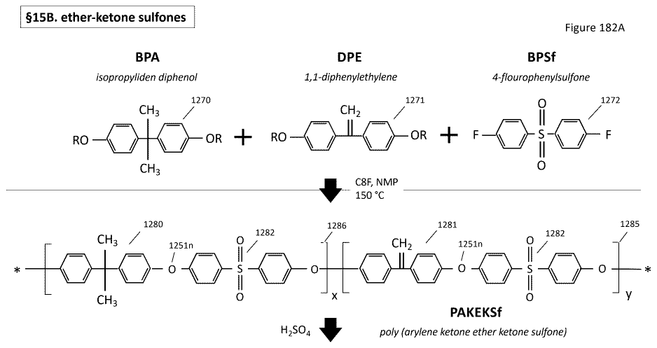

In the context of § 15A on sulfonated polyester sulfones sPESf, membrane top view 3000 and membrane side view 3001 in FIG. 180 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the thermoplastic heteropolymer polyether sulfones including PESf and PEESf as a mainchain 3009c optionally blended or cross-linked 3009x to poly ether imide (PEI) 3009b or other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups; where ionomeric polymer 3002 may include ionic fillers (not shown);
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

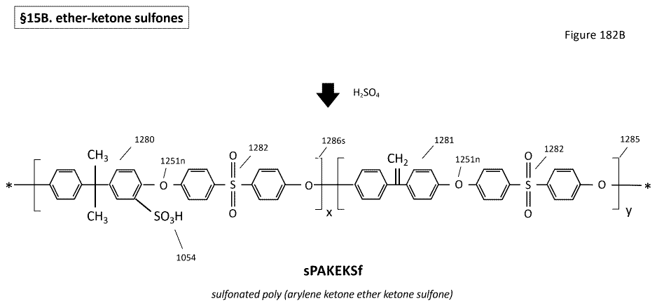

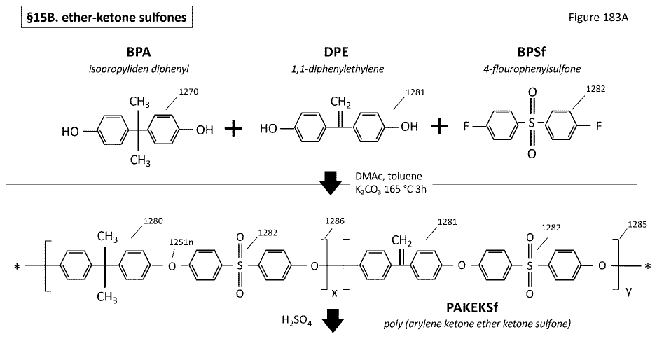

Other related polymers described in section § 15B including ketone sulfones and ether-ketone sulfones. As shown in FIG. 181A, 4,4′-difluorodiphenylsulfone (DFDPSU, DFDPSf, DFDPS) 1211 when combined with cyanide reactant 1277 and solvents dimethylformamide in nitrogen (DMF-N₂) and sodium hydride NaOH at room temperature, results in intermediary polymer 1278. Subsequent processing in acetic acid (AcOH) and hydrochloric acid (HCl) results in the polymer polyketone ketone sulfone (PKKSf, PKKS) 1279. In FIG. 181B, polyketone ketone sulfone (PKKSf) 1279 is functionalized into ionomeric polymer sulfonated polyketone ketone sulfone (sPKKSf) 1279s by the addition of sulfonic acid 1054.

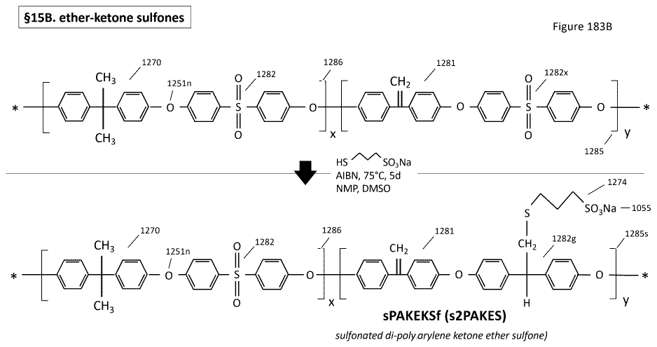

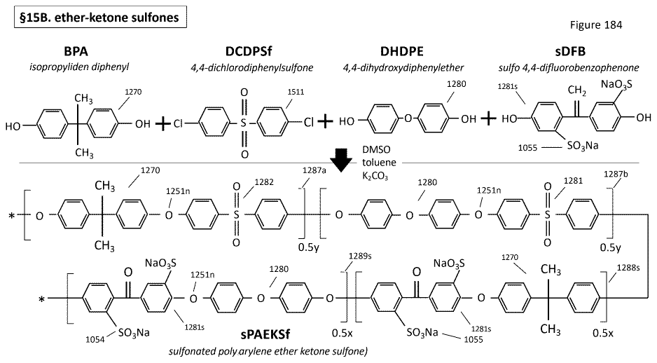

FIG. 182A illustrates a reaction of isopropyliden diphenol (BPA) 1270, 1,1-diphenylethylene (DPE) 1271, and 4-flourophenylsulfone (BPSU, BPSf, BPS) 1272 with octafluorocubane (C8F) and N-methyl-2-pyrrolidone (NMP) at 150° C. producing poly (arylene ketone ether ketone sulfone) (PAKEKSf, PAKEKS) comprising segments 1285 and 1286 including esters 1251n, sulfones 1282, and ketones 1280 and 1281.

Exemplary processes for forming ether-sulfone heteropolymers include forming poly(ether-ether sulfone)s and sulfonated poly(ether-ether sulfone)s derived from functionalized 1,1-diphenylethylene derivatives. The subsequent functionalization of PAKEKSf into an ionomeric polymer by sulfuric acid (H₂SO₄) 1055, comprises sulfonated segment 1286s with ionomer SO₃H and un-sulfonated segment 1285 is shown in FIG. 182B.

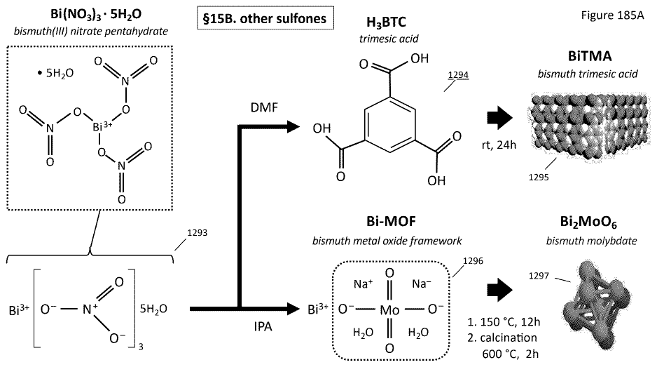

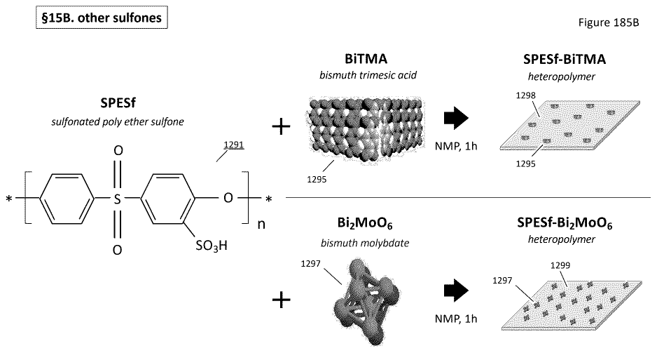

FIG. 183A illustrates an alternative method for synthesizing poly (arylene ketone ether ketone sulfone) (PAKEKSf, PAKEKS) comprising segments 1285 and 1286 from isopropyliden diphenyl (biphenyl A, BPA) 1270; 1,1-diphenylethylene (DPE) 1281, and 4-flourophenylsulfone (BPSU, BPSf, DPS) 1282 including sulphone groups 1282 and 1282x.

In FIG. 183B treatment by sulfonic acid (SO₃Na) and AIBN at 75° C. for 5 days followed by NMP and DMSO converts un-sulfonated polymeric segment 1285 into sulfonated segment 1285s by converting sulfone group 1282x into a mainchain graft point 1282g thereby attaching ionomeric sulfonic acid (SO₃Na) group 1055. At 5 days processing time, such a method is not commercially viable but does however demonstrate the functionalization of poly (arylene ketone ether ketone sulfone) (PAKEKSf) into sulfonated di-poly (arylene ketone ether sulfone) (sPAKEKSf, s2PAKES).

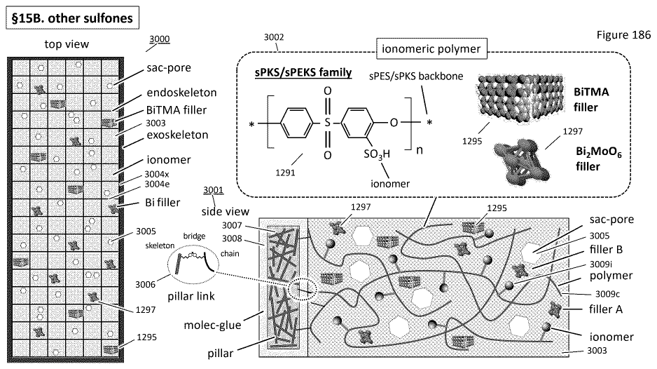

Various functionalized ionomeric linear copolymers comprising arylene, ester, ketone, and sulfone groups may also be formed. As depicted in FIG. 184 synthesis of a sulfonated poly(arylene ether ketone sulfone) copolymer (sPAEKSf, sPAEKS) involve the combination of isopropyliden diphenyl (biphenyl A, BPA) 1270; 4,4-dichlorodiphenylsulfone (DCDPhSf, DCDPS) 1511; 4,4-dihydroxydiphenylether (DHDPhE, DHDPE) 1280; and sulfo-4,4-difluorobenzophenone (sDFB) together with dimethyl sulfoxide (DMSO), toluene (C₆H₅CH₃), and potassium carbonate (K₂CO₃).

The resulting sPAEKSf linear copolymer comprises four segments—a methylated ester sulfone group 1287a, an ester sulfone group 1287b, a sulfonated methyl ester ketone group 1288s; and a sulfonated methyl ester group 1289s. Ionomeric functionalization is achieved through sulfonic acid (SO₃Na) group 1055 attaching to both sulfonated segments 1288s and 1289s of equal length 0.5x. Un-sulfonated groups 1287a and 1287b each of length 0.5y where x and y need not be equal and where the total length n is thereby the sum of the four segments n=(x+y).

Dopants may also be introduced into sulfonated poly ether sulfone (sPESf, sPES) membranes to enhance conductivity as depicted in FIG. 185A include nanostructures derived from bismuth(Ill) nitrate pentahydrate (Bi(NO₃)₃·5H₂O) 1293, the composition of which may vary by its subsequent chemical processing steps. As shown combining bismuth nitrate 1293 with benzene-1,3,5-tricarboxylic acid (trimesic acid, H₃BTC) 1294 and blending the mix with the catalytic stabilizer dimethylformamide (DMF) for 24 h at room temperature (rt) results in a the nanocrystalline matrix bismuth trimesic acid (BiTMA) 1295. Alternatively, dissolving bismuth nitrate 1293 in isopropyl alcohol (IPA) then blending it with bismuth metal oxide framework (Bi-MOF) 1296 comprising bismuth, molybdenum, sodium, and water for 12 h at 150° C. followed by calcination at 600° C. for 2h to remove the volatile solvents produces the nanocrystal bismuth molybdate (Bi₂MoO₆) 1297.

As shown in FIG. 185B, these dopants can then be applied to or molded within sulfonated poly ether sulfone 1291 using the solvent N-methylpyrrolidone (NMP) to form the heteropolymer ionomeric membranes, specifically bismuth trimesic-acid-doped sulfonated polyether sulfone (SPESf-BiTMA) membrane 1298 or bismuth-molybdate-doped sulfonated polyether sulfone (SPESf-Bi₂MoO₆) membrane 1299. Embedding bismuth nanoparticles as permanent fillers in ionomeric polymers in accordance with this invention offers benefits in proton conductivity in PEMs by providing additional proton-conducting pathways and/or by modifying the membrane's microstructure to enhance proton mobility. In anion exchange membranes (AEMs) In AEMs, bismuth compounds can enhance ionic conductivity by providing sites that facilitate anion transport with reduced molecular drag.

Bismuth compounds introduced into the polymer matrix can act as reinforcing agents, improving the mechanical strength and durability of the membrane, a feature particularly important for maintaining membrane integrity under operational stress and high-temperature conditions. The incorporation of bismuth permanent fillers can also enhance the flexibility and toughness of the membrane, reducing the likelihood of cracking or tearing. Bismuth compounds incorporated as nanoparticles also create a more uniform and finely structured membrane matrix, enhancing the dispersion of the fillers and improving the overall performance of the membrane. The incorporation of bismuth compounds into the matrix also invoke changes in the morphology of the membrane, such as pore size and distribution, beneficially influencing the membrane's transport properties and improving its overall efficiency. Bismuth enhances chemical stability, rendering making the film more resistant to degradation by chemical species such as free radicals, acids, or bases. Bismuth compounds can also be included in a nanoparticle coating or embedded into the catalyst layer. For example, made in accordance with this invention the addition of these bismuth compounds into the cathode catalyst layer (CCL) accelerate the oxygen reduction reaction (ORR), the rate limiting reaction in a PEM fuel cell.

In summary, membrane top view 3000 and membrane side view 3001 in FIG. 186 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the thermoplastic heteropolymers poly(ether-sulfone) aka sPES or poly(ketone-sulfone) as a mainchain 3009c optionally blended with other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers including bismuth trimesic acid (BTMA) 1295 and bismuth molybdate (Bi₂MoO₆) 1297;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table describes various structural elements of the hybrid sulfone class of membranes including ether sulfones, ketone sulfones, and ether-ketone sulfone heteropolymers. Sulfone heterogeneous polymers and copolymers comprising combinations of arylene, ketone, esters, and bismuth and copolymers of ether imide and poly(2-acrylamido-2-methyl-1-propanesulfonic acid) (PAMPS) collectively comprise a subset of poly(arylene ketone sulfones) and poly(arylene ketone ester sulfones). Numerous ionomer moieties are listed in the table.

Endoskeletal pillar materials or coatings able to bond to heterogenous sulfone compounds include epoxy adhesives and resins (EPX), polyimides (PI), silicone adhesives, polyurethane (PU), acrylic adhesives, along with other poly arylene ester sulfone, poly arylene ketone sulfone, and poly arylene ester ketone sulfone polymers (PAEKS) and various cyanoacrylates (CAc) including methyl groups (MCA), ethyl groups (ECA), N-butyl (N-BCA), octyl groups). Commonly abbreviated as CA cyanoacrylates herein as referred to as CAc to avoid confusion with citric acid (CA).

| ionomer | structure | endoskeleton | solvents, X-L | fillers |
|---|---|---|---|---|
| §15. ether sulfone, ketone | heterogenous | polymers: EPX, | solv: DMSO, | sac filler, CNTs, |
| sulfone, ether-ketone | sulfone polymers | HF-IPS, PAEK, PU, | NMP, Bz, xyl, | oxides, POSS, |
| sulfone heteropolymers | +arylene | PI, CAc | tol | NPs, MOFs, PIL |
| sPESf | +ketone | pillars: | X-L: Bz, BnOH, | |
| sPEESf | +esters | reinforcing fillers | DMF, NMP | |
| sPEDSf | +bismuth | (C-fibers, CNTs) | | |
| sPEESf-co-PEI | sulfone | | | |
| sP(PhEESf)-co-PAMPS | copolymers | | | |
| sFPESf | +ether imide | | | |
| sPKKSf | +PAMPS | | | |
| sPAKEKSf (s2PAKES) | | | | |
| sPAEKSf | | | | |
| SPES-BiTMA | | | | |
| SPES-Bi₂MoO₆ | | | | |

Solvents used in forming ether sulfone and ketone sulfone polymers include dimethylsulfoxide (DMSO), benzene (Bz), xylene (xyl), toluene (tol), hexafluoroisopropyl alcohol (HF-IPA). Solvents and cross linkers used in polymerization include N,N-dimethylformamide (DMF), N,N-dimethylacetamide (DMAc), N-methyl pyrrolidone (NMP), and biphenyl A (BPA), benzene (Bz), and benzyl alcohol (BnOH, cresol). Aside from the bismuth crystallites and nanoparticles BiTMA and Bi₂MoO₆ described in the section, membrane fillers and dopants described previously have been omitted for the sake of brevity, and will not be repeated here.

Although described separately in the previous sections, poly arylene ethers (PAEs) include poly arylene ketones, poly ether ketones, poly ether sulfones, poly ketone sulfones, and poly ether ketone sulfones—all of which include an arylene group. Arylene is a broad class of bivalent radicals (as phenylene) derived from an aromatic hydrocarbons by removal of a hydrogen atom from each of two carbon atoms of the nucleus.

§ 16. Functionalized Hybrid Polymer IEMs with Carbon Fillers.

In common speech, the term hybrid means the mixing two or more different components in the composition of something. In the lexicon of chemistry and material science, the term hybrid is more definitive, applying both to the nature of chemical bonding and to materials formed therefrom. Specifically in localized valence theory, a hybrid chemical bond comprises atomic orbitals of different yet interacting elements or molecules sufficiently similar to accommodate persistent electrostatic attraction. If the attraction is sufficiently strong and the orbitals reasonably compatible, a chemical bond will result.

Although all chemical bonds are governed by physics, specifically the laws of electromagnetics defined by Maxwell and Gauss, the type of bond, namely Van der Waals, hydrogen, ionic, or covalent depends on the attractive force between atoms and other factors such as 3D-shape. Specifically if the outer atomic shell of an element is completely filled, the element is generally unreactive, e.g. in the case of group VIII (group 18) noble gasses like neon and xenon.

In the cases of elements having one fewer or one more electron than a fully filled electronic shell, chemical reactivity in such high electronegative or electropositive elements such as Li, Na, K, and F is significant, often leading to ionic bonds. Fluorine forms especially strong bonds to carbon, which explains the chemical resilience of PTFE. Other factors enabling or preventing hybrid bonds include quantum mechanical effects such as orbital splitting and the Pauli exclusion principle, polar vs nonpolar molecules, and hydrophobicity vs hydrophilicity.

Hybrid bonding is an especially important factor in forming manmade crystals such as GaAs, GaN, and InP; and in forming hybrid polymers. Specifically in polymer chemistry, a hybrid polymer is a material containing two or more different types of molecules. Hybrid polymers either comprise a copolymer comprising two different polymers bonding by a cross linking molecule such as glutaraldehyde, formaldehyde, etc. Copolymers generally involve independent synthesis of the separate monomers later polymerized into homopolymer strands and subsequently cross-linked to form the homopolymers.

The separate strands may be arranged linearly on a common mainchain, may form branches off of one another, or may comprise distinct backbones bridged together by cross-linking ligands. If the homopolymer segments are long, the copolymers are referred to as block polymers (discussed later in the application. A heteropolymer by contrast comprises dissimilar monomers polymerized into a heterogenous backbone concurrently, i.e. the monomers are contemporaneously polymerized and linked.

Another form of hybrid polymer is any homopolymer and heteropolymer doped by a permanent filler such as carbon, silicates, zeolites, tungsten crystals, POSS, MOFs or other additives. Herein, copolymeric and doped membranes are therefore referred to as hybrid polymers. In the context of this invention, a carbon filled membrane is a polymeric membrane containing permanent fillers containing carbon compounds, crystals, and matrices such as pristine graphene, graphene oxides, carbon nanotubes, carbon nanospheres, carbon nanofibers, and other carbon compounds. Other allotropes of carbon include diamond, graphite, ionsdaleite, buckminsterfullerene (C₆₀), fullerene (C₅₄₀ and C₇₀), amorphous carbon, cyclocarbon, carbon nanobuds, schwarzites, glassy carbon, and linear acetylenic carbon (carbyne).

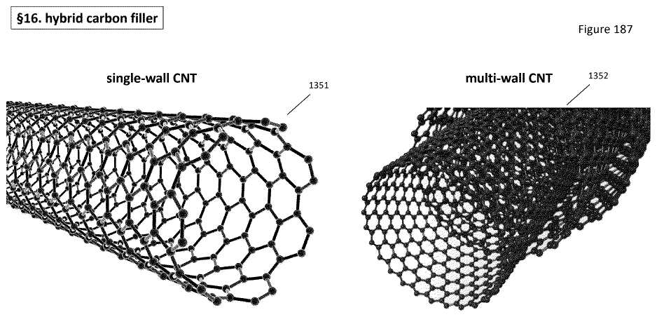

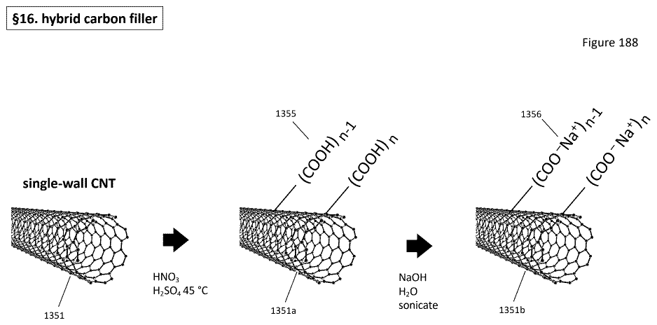

Among these, carbon nanotubes (CHTs) represent a highly useful allotrope of carbon comprising hollow tubes made of rolled up sheet of graphene, i.e. single atomic layers of carbon. Shown in FIG. 187 (canatu.com), single wall carbon nanotubes (SWCNTs) comprise a single atomic layer of carbon forming a long hollow tube of hexagonally shaped tiles of carbon. Multi-walled carbon nanotubes (MWCNTs) consist of nested single-wall carbon nanotubes, i.e. concentrically layered as a tube-within-a-tube. As such, multiwalled carbon nanotubes increase the net carbon wall thickness and total nanotube diameter, resulting in a higher surface area of the CNT. For example, a doubling in CNT diameter increases the surface area of the CNT by four times. Double- and triple-walled carbon nanotubes (DWCNT, TWCNT) are common variants of MWCNTs.

As a material, carbon nanotubes exhibit extraordinary tensile strength, high thermal conductivity, and high durability. Although pure carbon nanotubes is considered a moderate conductor, surface treatment with ionomeric groups and metals can dramatically influence its conductivity much like chemical doping of semiconductors such as silicon can change its conductivity by many orders-of-magnitude.

Using the classic electronic shell terminology for the periodic table of elements, carbon like silicon is a group 14 (or classically group IV) element, meaning both carbon and silicon contain four valance electrons in a shell requiring eight electrons to complete. Covalent bonding with itself or other group IV elements can result in complete elimination of ionized conduction electrons, making CNT behavior that of a semiconductor. As a semiconductor, minor changes in the concentration of surface dopants can dramatically influence conduction. As such, doping CNTs can greatly enhance conductivity by forming surface bonds easily ionized. For example any bond broken at energies less than the thermal energy kT/q, 0.026 eV at room temperature, releases a free electron into the conduction band contributing to conduction. In this sense, carbon nanotubes electrical conductivity ranges from that of a good conductor to that of a semiconductor. Interestingly, the bandgap of a CNT decreases with its diameter, meaning the larger the CNT, the more conductive it becomes.

A CNT can also be functionalized by attaching ionomeric or catalytic groups onto its surface. Conversely insulating CNTs can be made through oxidation of carbon surfaces. Functionalization of carbon nanotubes has many diverse uses including electromechanical actuation using ionic polymer metal composite actuators based on sulfonated poly(1,4-phenylene ether-ether-sulfone)-carbon nanotubes. Other processes attach functional groups to the CNT surface. For example, as shown in FIG. 188, single-walled carbon nanotube 1351 treated by a nitric-sulfuric acid (HNO₃—H2_{S}O₄) mixture at 45° C. results in attachment of carbocyclic acid groups (COOH) 1355 onto CNT 1351a. Subsequent sonication of decorated CNT 1351b in aqueous NaOH results in a substitution reaction of hydrogen by sodium ion Na⁺ 1356.

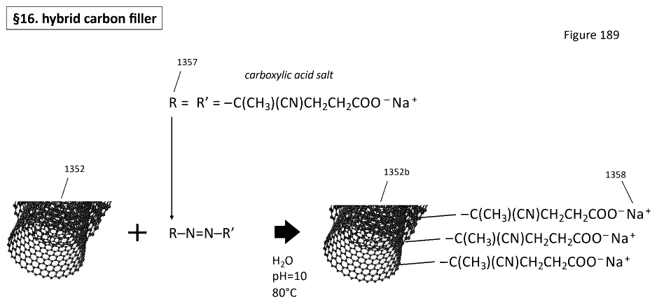

Carbon nanotubes can be used to enhance Nafion® membranes by introducing functionalized multiwalled carbon nanotubes into the polymer. As shown in FIG. 189, carbon nanotube 1352 is blended with co-reactant R—N═N—R′ in 80° C. alkali water at pH=10 and where R═R′ 1357 is a carboxylic acid salt C(CH₃)(CN)CH₂CH₂COO⁻ Na⁺) resulting in decorated CNT 1352b functionalized by sodium salt 1358. The ionic terminus can then be replaced by any number of termini.

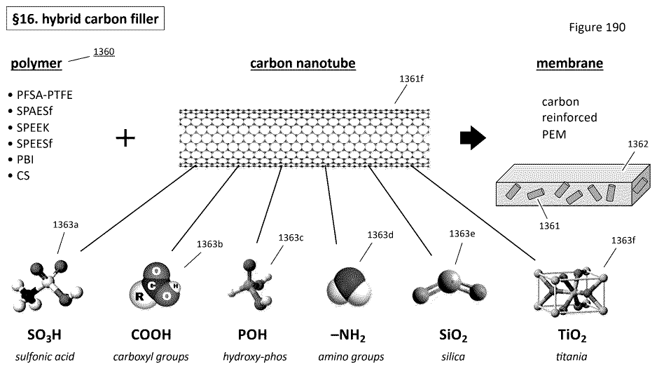

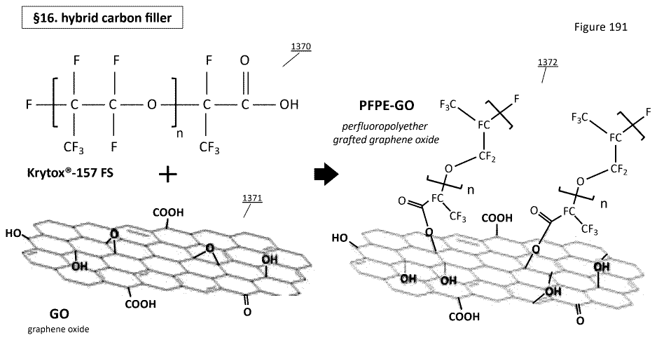

Exemplary ionomeric activation of functionalized carbon nanotubes is depicted in FIG. 190 where carbon nanotube 1361 may be functionalized by sulfonic acid (SO₃H) 1363a, carboxyl group (COOH) 1363b, phosphorus hydroxide (POH) 1363c, amino group (—NH₂) 1363d, silica or silicate (SiO₂) 1363e, or titania (TiO₂) 1363f. In accordance with this invention, the functionalized carbon nanotubes 1361f may be combined with a variety of polymers 1360 such as PFSA, PFSA-PTFE, sPAESf, sPEEK, sPEESf, PBI, CS and others to form a nanotube doped membrane 1362.

As such, the inclusion of functionalized or un-functionalized carbon nanotubes into a polymer can affect its mechanical and electrical properties. Nanotubes can also influence film morphology. The diameters of CNTs is measured in nanometers with single walled carbon nanotubes (SWCNTs) having diameters between 0.5 nm to 2 nm. With lengths up to several microns or longer, CNTs can have length-to-width aspect ratios of 4000. Comparable in dimension to long polymers, the presence of long CNTs in a membrane can affect crystallinity, porosity, and fuel crossover. One problem is that CNTs are so small they may be mobile under certain conditions, escaping from the membrane if they are not properly tethered or constrained. One such method is to employ an endoskeleton and membrane nanocoating to constrain their movement in a manner similar to the inventive embodiment herein used to prevent leakage of ionic liquids (ILs).

Made in accordance with this invention, carbon nanotubes may be used in a variety of beneficial ways in a ionomeric membrane, namely,
as a permanent filler comprising unfunctionalized CNTs added to endoskeletal pillars providing enhance mechanical strength, improved film rigidity, and greater thermal conductivity,
as a permanent filler added to a catalyst layer comprising a catalyst functionalized nanotubes to enhance reaction rates, particularly for cathode side oxygen reduction reactions (ORRs),
as a permanent filler added to an ion exchange membrane comprising a metal or ionomer functionalized CNT to enhance conductivity.
as a permanent filler added to an ion exchange membrane comprising CNTs which together with the application of sacrificial fillers, control the porosity of a ion exchange membrane.

Aside from the use of carbon nanotubes, graphene oxides (GO) comprise another category of carbon filler beneficial as a permanent filler in an ion membrane. Unlike CNTs which behave as metals or semiconductor depending on doping, graphene oxide function as two-dimensional semimetals. One prospective process for functionalizing GO involves sulfonating poly(arylene ether sulfone) to form a composite membrane with perfluorosulfonic acid containing perfluoropolyether grafted graphene oxide. Graphene oxide may be functionalized 1371 by Krytox®-157-FS, a fluorinated surfactant 1370 to produce perfluoro-polyether grafted graphene oxide (PFPE-GO) 1372.

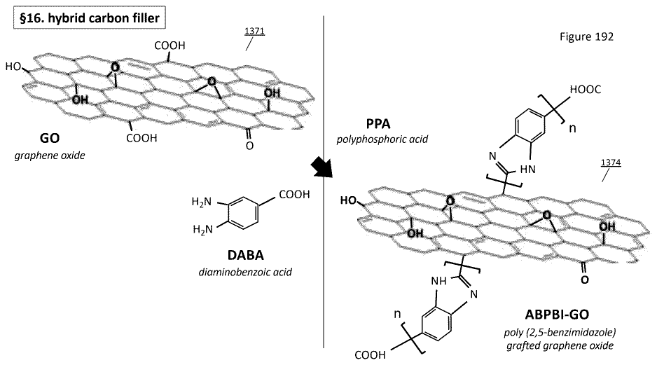

Another prospective process involves introducing a poly(2,5-benzimidazole)-grafted graphene oxide into proton exchange membrane to enhance conductance. FIG. 192 converts graphene oxide (GO) 1371 through a reaction of polyphosphoric acid (PPA) with diaminobenzoic acid (DBA) to produce poly (2,5-benzimidazole) grafted graphene oxide (ABPI-GO) 1374.

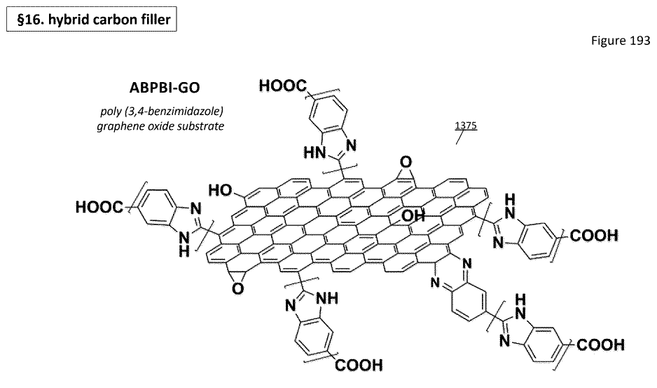

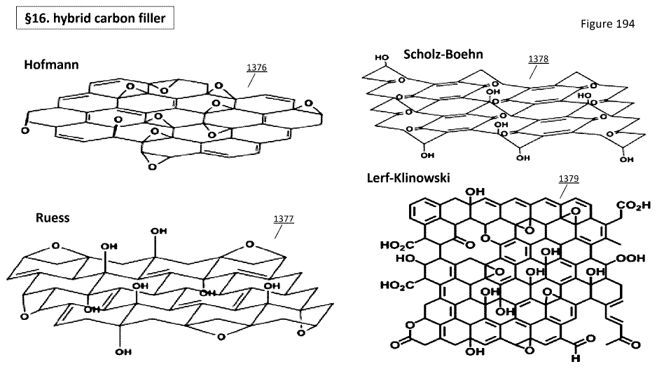

Another functionalized GO variant comprising poly (3,4-benzimidazole) graphene oxide (ABPI-GO) substrate shown in FIG. 193 involves forming a sulfonated poly(arylene ether sulfone) composite membrane containing poly(2,5-benzimidazole)-grafted graphene oxide. Variations in the molecular structures of graphene substrates shown in FIG. 194 are described in greater detail in a University of Manchester 2016 thesis paper by SI Al-Batty.

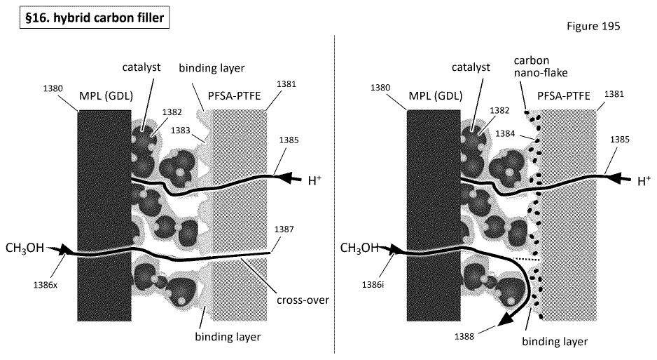

FIG. 195 illustrates the application of GO carbon nanoflakes 1384 in an ion exchange membrane. As shown the interface between the MPL portion of gas diffusion layer 1380 and a PFSA-PTFE reinforced composite membrane 1381 includes an amorphous matrix of 1382 and binding material 1383. Without carbon doping operation of a direct methanol fuel cell involves hydrogen transport 1385 through the electrolyte and into the cathode to facilitate conduction. Unfortunately a portion of fuel comprising methanol (CH₃OH) transported to the interface crossover through the membrane and into the anode as depicted by path 1386x disrupting efficient operation of the fuel cell. Addition of carbon nanoflakes 1384 into binding layer 1383 interferes with methanol transport 1386i resulting in rejection of methanol 1388 at the surface at the PFSA-PTFE membrane 1381. In this manner inclusion of carbon into the catalyst layer or upon the PEM membrane suppresses fuel crossover and improved fuel cell conversion efficiency.

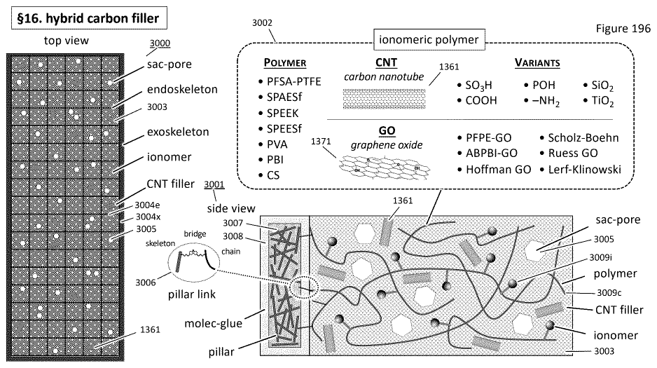

In summary, membrane top view 3000 and membrane side view 3001 in FIG. 196 illustrate a variety of elements of ionomeric polymers 3002 containing carbon fillers made in accordance with this invention, including separately or in combination with other inventive matter comprising
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber, or carbon nanotubes, or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) which may include functionalized or catalyst coated carbon nanotubes is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise any polyolefin or thermoplastic homopolymer or heteropolymer as a mainchain 3009c including PFSA-PTFE, SPAES, SPEEK, SPEES, along with sulfonated PP, PE, PU, PC, PI, PBI or CS optionally blended with other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers including carbon nanotubes 1361 coated with either SO₃H, COOH, POH, —NH₂, SiO₂, or TiO₂; and/or graphene oxide GO 1371 including PFPE-GO, ABPBI-GO, Hoffman GO, Scholz-Boehn GO, Ruess GO, or Lerf-Klinowski GO;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR₄⁺; phenolic hydroxyl groups —OH, or any other acidic group which easily ionizes to donate conducting cations of H⁺, Na⁺, or K⁺ into the solid electrolyte; and finally,
where the combination of the endoskeletal pillars and the membrane coating are used to seal in any ionic liquid doping to prevent seepage, leakage, or IL depletion, or loss of CNT fillers added into the matrix.

The following table describes carbon filled ionomeric and catalytic polymers and membranes:

| ionomer | structure | endoskeleton | solvents, X-L | fillers |
|---|---|---|---|---|
| §16. carbon filled | heterogenous | polymers: matched | solv: matched to | sac filler, CNTs, |
| polymers | carbon filled | to IEM ionomer | IEM polymer; | oxides, POSS, |
| PFSA-PTFE | polymers | pillars: reinforcing | X-L: cross linkers | NPs, MOFs, PIL |
| PFSA-PVA-PTFE | | fillers (C-fibers, CNTs) | matched to IEM | including CNTs, |
| SPAES, sPEEK, sPEES | | | polymer type | GO |
| sPVA | | | | |
| PBI, CS | | | | |

Unlike previously cited polymers, the addition of permanent carbon fillers is agnostic to the polymer used to form a membrane or to construct the endoskeletal. Instead in accordance with this invention, carbon compounds confer several unexpected benefits including (a) carbon fiber or un-functionalized nanotubes can be embedded into inert pillars to mechanically strengthen the membrane's endoskeletal support, (b) catalyst or scavenger functionalized nanoparticles or carbon functionalized nanotubes as a coating to improve catalytic activity and balance redox reaction rates and/or protect against catalyst poisoning, and (c) permanent fillers comprising functionalized carbon nanotubes and/or functionalized graphene oxides to enhance film conductivity, control film porosity, improve membrane strength, reduce polymer swelling, and manage fuel crossover in DMFCs.

§ 17. Functionalized Hybrid Polymer IEMs with Silica Fillers.

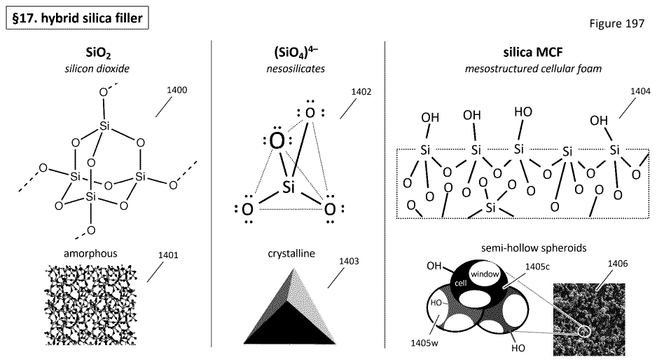

Although intrinsically not as electrically or chemically active as carbon fillers, silicon based fillers can also be functionalized to improve conductivity while enhancing film strength. Silicon, the most carbon-like element in the periodic table is another group IV element with four filled valance electrons in an eight electron shell. As such, silicon can be processed to form insulators such as amorphous glass and oxides; to form semiconductors comprising a hyper-pure single-crystal ingots, wafers, chips, and nanoparticles; and to form conductors of metal crystallites and quasi-crystals. FIG. 197 illustrates the various morphologies

A comparison of silicates, i.e. oxidized silicon is available online, e.g. on Britannica website, and through various papers discussing the formation and uses of large-pore mesostructured cellular foam (MCF) silica. The electrical behavior of oxidized silicon compounds is closely related to chemical morphology, structures which include amorphous structures 1401 such as silicon dioxide (SiO₂) 1400; crystalline forms 1403 such as nesosilicates ((SiO₄)⁴⁻) 1402; and silica MCF 1404 aka mesostructured cellular foam 1406. MCF 1404 particles are considered foam-like as they comprise semi-hollow silica spheroids 1405c with windows 1405w. These spheroids easily bond to hydroxide (OH) outside the spheroid boundary.

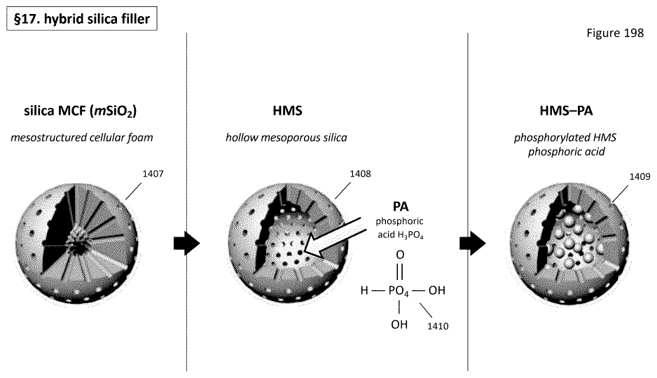

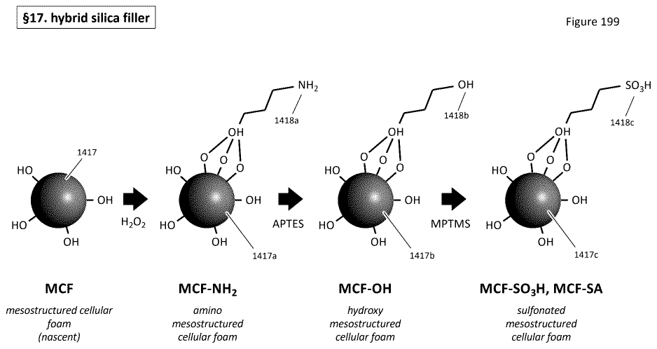

FIG. 198 illustrates the formation of hollow mesoporous silica (HMS) 1408 from silica MCF mesostructured cellular foam (mSiO₂) 1407, subsequently doped by phosphoric acid (H₃PO₄) 1410 to produce phosphorylated hollow mesoporous silica phosphoric acid (HMS-PA) 1409. Morphological features of mesostructured cellular foam of silica may be etched to create hollow centers able to capture catalysts, acids, or ionomeric groups much the same as guest molecules in metal organic frameworks (MOFs).

A process to functionalize mesoporous silica nanospheres is illustrated in FIG. 199 starting with nascent mesostructured cellular foam (MCF) 1417 with OH surface bonds treated by water (H₂O₂) to produce amino mesostructured cellular foam (MCF-NH₂) 1417a with NH₂ terminus 1418a. Subsequent treatment of (MCF-NH₂) 1417a by (3-aminopropyl)triethoxysilane (APTES) produces hydroxy mesostructured cellular foam (MCF-OH) 1418b with OH terminus 1418b. Treatment of hydroxy MCF 1417b by (3-mercaptopropyl)trimethoxysilane (MPTMS) results in sulfonated mesostructured cellular foam (MCF-SO₃H, MCF-SA) 1417c including sulfonic acid (SO₃H) 1418c. Prospective applications for functionalized MCFs include a variety of polymers including sulfonated poly(ether-ether sulfone)

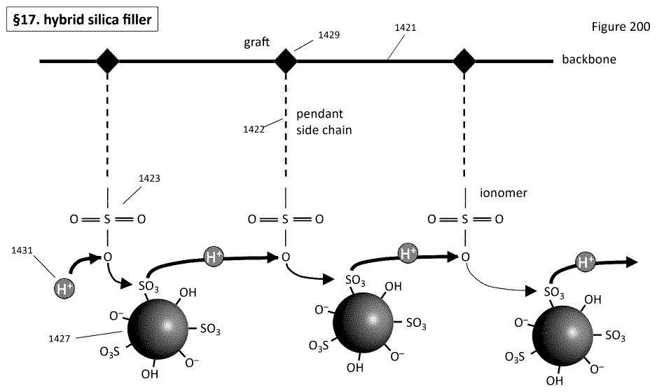

FIG. 200 illustrates the role of mesostructured cellular foam (MCF) 1427 in ionomer conduction involving ionomeric hopping conduction. As shown, ionomer backbone 1421 connects to pendant sidechains 1422 with sulfonic acid termini 1423 and nearby mesostructured cellular foam (MCF) 1427. During ionic hopping conduction, proton 1431 bonds to ionomer 1423 then hops to a NH₂ group attached to MCF 1427. The proton next jumps to a second ionomeric sulfonic acid group and the process is repeated. The presence of sulfonated mesostructured cellular foam 1427 particles thereby assist in charge transport by creating more conduction paths involving the MCF not limited to ionomer-to-ionomer hopping.

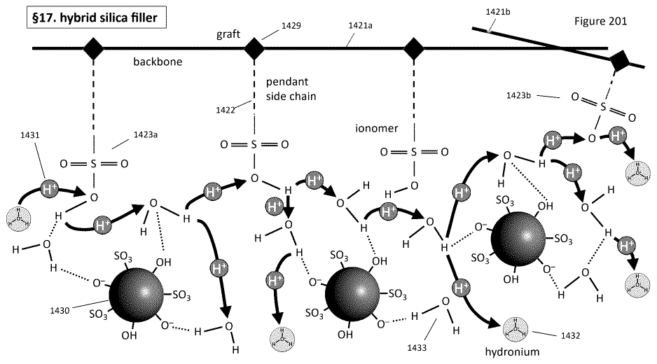

By contrast, MCF assisted vehicular transport of protons shown in FIG. 201 comprises the conduction of excess protons in the form of hydronium ions 1432 which may spontaneously revert to hydrogen ions 1431 or vise versa as they traverse the matrix. As depicted H⁺ attaches itself to neutral water (H₂O) molecules 1433 to form hydronium ions (H₃O). In pure vehicular transport these hydronium ions may drift through the matrix in response to an electric field of may diffuse as a consequence of a concentration gradient. In hybrid conduction a free hydrogen ion may bond onto ionomer 1423a then detach itself only to ionize another water molecule into hydronium, and repeat the process. In this manner protons alternate between bonding onto immobile ionomers grafted 1429 or attached to polymer backbone 1421a then jumping onto free moving water molecules and transported as vehicular hydronium.

Because excess protons in the matrix form hydrogen bonds with water (H₂O) molecules shown as dotted lines, the spider-web of hydrogen bonds provides additional structural support to the matrix of ionomers and polymers. For example through this tenuous fluid network, ionomer 1423b indirectly bonds polymer backbone 1421b to polymer backbone 1421a even there is no covalent bonding between the two polymer mainchains. The addition of mesostructured cellular foam 1430 further contributes to the hydrogen bonding network by forming additional hydrogen bonds between water droplets in the matrix and the O⁻ and OH groups present of the MCF's surface. In this manner, the introduction of mesostructured cellular foam 1430 a permanent filler in the membrane helps regulate water sorption and membrane swelling. This mechanism occurs even if the MCF is not functionalized by sulfonic acid, i.e. even if there are no SO₃ groups present on the surface of MCF 1430.

Note that FIG. 201 shows only vehicular and hybrid transport but neglects cation transport involving MCF sulfonic surface groups shown in the previous figure. In reality both mechanisms of vehicular transport and charge hopping are concomitant, occurring concurrently throughout the ionomer matrix. As such, the introduction of MCF into a ionomeric polymer made in accordance with this invention can regulate hydration, improve film strength, and enhance conductivity. When the permanent MCF viler is combined with the aforementioned sacrificial filler process controlling porosity, the import of a polymer's hydrophobicity on conductivity is diminished.

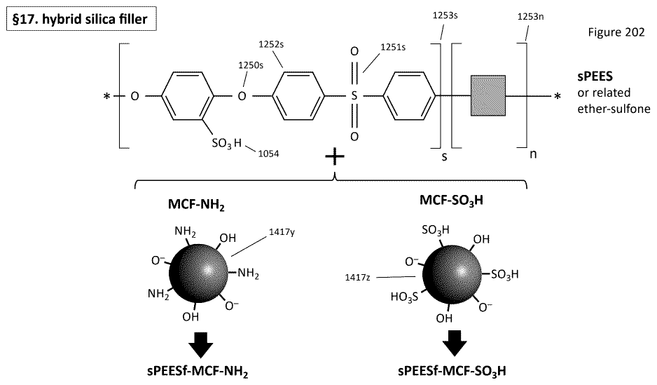

The process of doping a membrane involves introducing the MCF into the mold during casting. The morphological and electrical changes to the otherwise undoped pristine ionomer depend on the species of MCF added during synthesis. For example as shown in FIG. 202, the addition of an amino doped mesostructured cellular foam (MCF-NH₂) 1417y to a polymer comprising a sulfonated ionomer such as sPEESf 1253s and un-functionalized ether-sulfone segment 1253n results in a new ionomeric membrane sPEESf-MCF-NH₂ having mechanical and electrical properties neither component offers on its own. Similarly the addition of sulfonated mesostructured cellular foam (MCF-SO₃H) 1417z to sulfonated ionomer sPEESf 1253s results in a new film sPEESf-MCF-SO₃H having a greater density of sulfonic groups 1054 and higher conductivity than sPEESf itself can achieve.

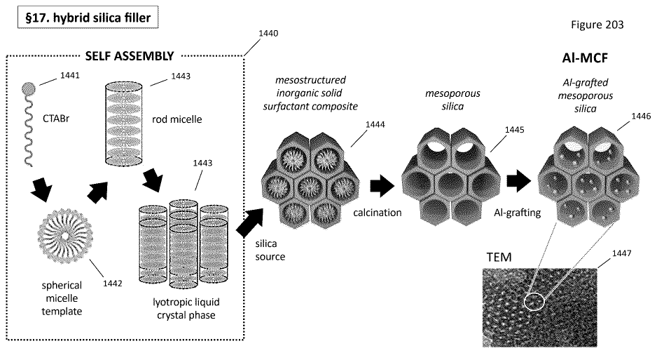

Silica based mesostructured cellular foam can given the right conditions and adequate time be processed to exhibit self-assembly of macrostructures. As shown in FIG. 203, starting with CTABr1441, the quaternary ammonium surfactant known as cetrimonium bromide with the condensed structural formula (C₁₆H₃₃)N(CH₃)₃]Br, a spherical micelle template 1442 is synthesized which self assembles 1440 into rod micelles 1443 and ultimately into a lyotropic liquid crystal phase 1442. According to Wikipedia, lyotropic liquid crystals comprise amphiphiles, which are both hydrophobic and hydrophilic, dissolved into a solution that behaves both like a liquid and a solid crystal.

Made in accordance with this invention include channel-embedded aluminum-substituted mesoporous silica may be used to enhance conductivity in high-temperature anhydrous proton-exchange membrane fuel cells. These self assembled silica crystallites form a mesostructured inorganic solid surfactant composite 1444 which can be further modified by calcination, i.e. heating solids at a high temperature to remove volatile substances or oxidizing a specific amount of mass, to form a honeycomb silicate structure referred to as mesoporous silica 1445. The mesoporous silica is then functionalized by grafting aluminum or other metals onto the substrate to form an isomeric MCF comprising Al-grafted mesoporous silica 1446 as illustrated in the transmission electron micrograph 1447. The aluminum MCF ionomer can then be introduced into a non-fluorinated membrane such as phenylene-bibenzimidazole (PBI) for use in a direct methanol fuel cell (DMFC).

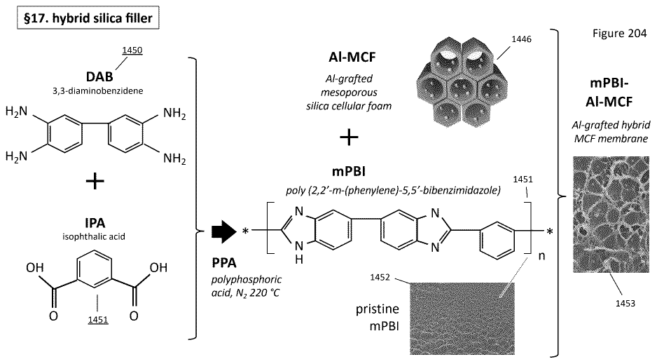

One such process for Al-MCF doping of PBI is shown in FIG. 204 where 3,3-diaminobenzidene (DAB) 1450 is combined with isophthalic acid (IPA) 1451 in the presence of polyphosphoric acid (PPA) and N₂ at 220° C. to form poly (2,2′-m-(phenylene)-5,5′-bibenzimidazole) (PBI) 1451. Shown in its pristine form mPBI exhibits a small grain structure 1452. The addition of Al-grafted mesoporous silica cellular foam (Al-MCF) 1446 using a sol-gel process results in a Al-grafted hybrid MCF membrane (mPBI-Al-MCF) having a completely different morphology s shown in the TEM 1453 compared to pristine PBI 1452.

Doping of PBI with permanent fillers of Al-MCF is important in high temperature fuel cells, i.e. operating above 100° C. to prevent acid leaching from the membranes while limiting fuel crossover. The introduction of an Al-substituted hexagonally ordered mesoporous silica (Al-MCM) channel into poly(2,2′-m-(phenylene)-5,5′-bibenzimidazole) (m-PBI) membrane markedly enhances the reliability of a PBI membrane. Moreover Al-MCM channels enables a mPBI composite membrane to absorb increased H₃PO₄, thereby improving proton conductivity and high temperature fuel cell performance.

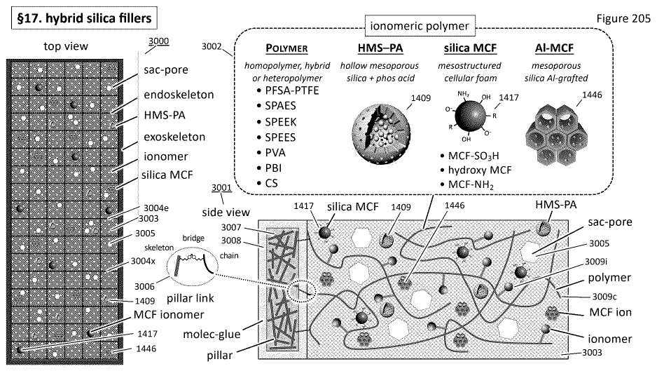

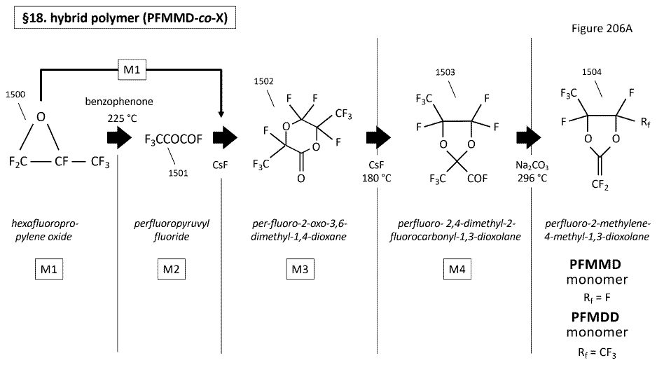

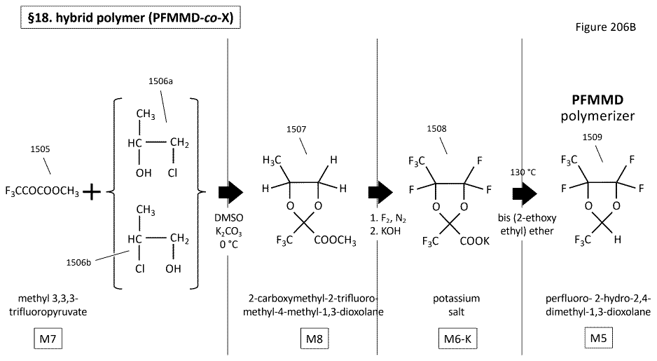

Membrane top view 3000 and membrane side view 3001 in FIG. 205 illustrate a variety of elements of ionomeric polymer 3002 with silica fillers made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise any polyolefin or thermoplastic homopolymer or heteropolymer as a mainchain 3009c including PFSA-PTFE, SPAES, SPEEK, SPEES, PI, PE, PC, PBI or CS optionally blended with other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers including hollow phosphoric acid doped mesoporous silica (HMS-PA) 1409, mesostructured cellular foam (silica MCF) 1417 including MCF-SO₃H, hydroxy MCF, or MCF-NH₂; and Al-grafted mesoporous silica 1446 forming a hybrid membrane with poly (2,2′-m-(phenylene)-5,5′-bibenzimidazole) aka mPBI;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table describes the use of silica fillers in a variety of polymeric membranes:

| ionomer | structure | endoskeleton | solvents, X-L | fillers |
|---|---|---|---|---|
| §17. silica filled | heterogenous | polymer: matched | solv: matched to | HMS-PA, Si-MCF, |
| polymers | silica filled | to IEM polymer; | IEM polymer; | MCF-SO₃H, MCF-OH, |
| PFSA-PTFE | polymers | pillars: reinforcing | X-L: cross linkers | MCF-NH₂, Al-MCF |
| PFSA-PVA-PTFE | | fillers (C-fiber, CNTs, | matched to IEM | sac filler, CNTs, |
| SPAESs, sPEEK, | | silica, silicates) | polymer type | oxides, POSS, |
| sPEESf | | | | NPs, MOFs, PIL |
| sPVA, CS | | | | |
| PBI, PBU-co-Al-MCF | | | | |

Heterogenous membranes comprising a variety of polymers doped with hollow phosphoric acid doped mesoporous silica (HMS-PA), mesostructured cellular foam (silica MCF) including MCF-SO₃H, hydroxy MCF, or MCF-NH₂; and Al-grafted mesoporous silica 1446 especially when forming a hybrid membrane with poly (2,2′-m-(phenylene)-5,5′-bibenzimidazole) aka mPBI. The construction of the endoskeleton and membrane depend on the polymer itself, not on the high temperature capable silica filler. The permanent silica filler may however be combined with the sacrificial filler process described herein to further control conductivity and fuel crossover.

### § 18. Functionalized Hybrid Perfluoro-Methyl-Dioxolane (PFMMD-Co-PFSA) Copolymer IEMs.

Compared to glassy amorphous membranes made of perfluoro-methylene-methyl-dioxolane (PFMMD) homopolymers described in § 3, another approach to forming ionomeric membranes comprises forming a copolymer of PFMMD with perfluorinated sulfonic acid (PFSA). As described previously PFSA films are attached to polytetrafluoroethylene (PTFE) backbone providing mechanical rigidity but limiting gas perfusion by its semi-crystalline morphology. Although PFSA membranes with PTFE polymeric backbones offer good mechanical strength, the ionomer suffers significant mass-transport losses and excessive heating at high currents, thereby limiting its useful power density, especially at low Pt loadings. Replacing PTFE mainchains with PFMMD introduces amorphous areas improving charge transport and enhancing film conductivity.

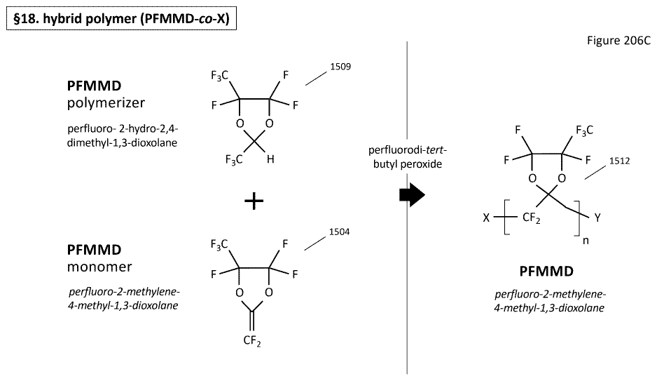

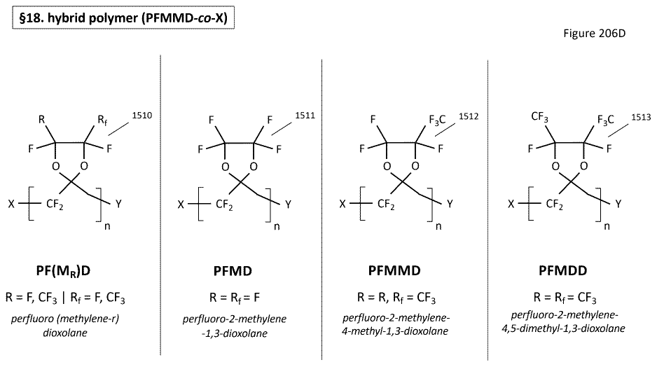

An exemplary process to synthesize the amorphous polymer poly(perfluoro-2-methylene-4-methyl-1,3-dioxolane) (PFMMD) made in accordance with a Dupont patent is illustrated in FIG. 206A, where hexafluoropropylene oxide 1500 is treated by benzophenone at 225° C. to form perfluoropyruvyl fluoride (F₃CCOCOF) 1501. Combining the two with cesium fluoride (CsF) to form perfluoro-2-oxo-3,6-dimethyl-1,4-dioxane 1502. Further treatment by CsF at 180° C. forms perfluoro-2,4-dimethyl-2-fluorocarbonyl-1,3-dioxolane 1503, which is converted by sodium carbonate (Na₂CO₃) at 296° C. into perfluoro-2-methylene-4-methyl-1,3-dioxolane 1504, a monomer of PFMMD where Rf═F. Note that if the radical Rf is replaced with CF₃, the monomer name is changed to PFMDD.

FIG. 206B illustrates synthesis of a PFMMD copolymer from the combination of methyl 3,3,3-trifluoropyruvate (F₃CCOCOOCH₃) 1505 and chlorinated methyl stereo isomers 1506a and 1506b in dimethyl sulfoxide (DMSO) and potassium carbonate (K₂CO₃) at 0° C. to produce 2-carboxymethyl-2-trifluoro-methyl-4-methyl-1,3-dioxolane 1507. Subsequent treatment in potassium hydroxide (KOH) in a F₂—N₂ ambient produce potassium salt 1508 which is readily converted by bis(2-ethoxyethyl) ether at 130° C. into PFMMD polymerizer perfluoro-2-hydro-2,4-dimethyl-1,3-dioxolane 1509.

FIG. 206C illustrates the polymerization process combining the PFMMD monomer comprising perfluoro-2-methylene-4-methyl-1,3-dioxolane 1504 and PFMMD polymerizer perfluoro-2-hydro-2,4-dimethyl-1,3-dioxolane 1509 in perfluoro-di-tert-butyl peroxide results in perfluoro-2-methylene-4-methyl-1,3-dioxolane (PFMMD) 1512.

FIG. 206D contrasts variations of perfluoro(methylene-R) dioxolane PF(M_{R})D 1510 where the radicals R and R_{f} may comprise either F or CF₃. As described previously, in the case of perfluoro-2-methylene-4-methyl-1,3-dioxolane (PFMMD) (1512) the radicals R═F and Rf═CF₃. For perfluoro-2-methylene-1,3-dioxolane (PFMD) (1511) both radicals comprise fluorine R═R_{f}=F. Alternatively, for perfluoro-2-methylene-4,5-dimethyl-1,3-dioxolane (PFMDD) 1513, both radicals R═Rf═CF₃.

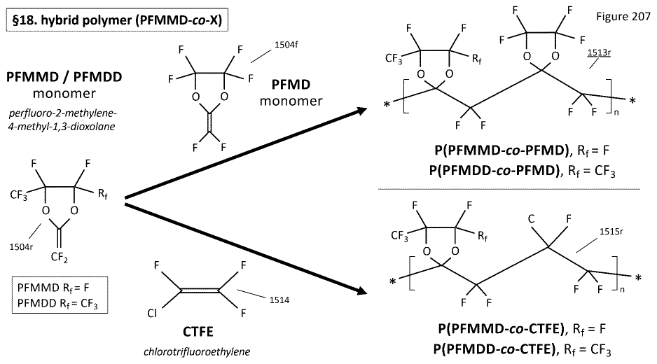

FIG. 207 illustrates a process for polymerizing perfluoro(methylene-r) dioxolane monomers into copolymers starting with PFMMD/PFMDD monomer 1504 where for PFMMD, R_{f}═F and for PFMDD Rf═CF₃. Combining the PFMMD version of monomer 1504 where Rf═F with the PFMD monomer 1504f forms the copolymer poly(PFMMD-co-PFMD) or in shorthand as P(PFMMD-co-PFMD). The generic structure of the copolymer with radical Rf is labelled as 1513r, while the specific instance where R_{f}═F, i.e. P(PFMMD-co-PFMD) is referred to a 1513p.

Combining the PFMDD version of monomer 1504 where Rf═CF₃ with PFMD monomer 1504f forms a structurally related copolymer poly(PFMDD-co-PFMD) 1513r except for the different radical Rf. In shorthand the tri-copolymer is referred to as P(PFMDD-co-PFMD) 1515r. Although the generic structure of the copolymer with radical R_{f} is labelled as 1513r, the specific instance where R_{f}═CF₃, i.e. P(PFMDD-co-PFMD) is referred to a 1513m.

Alternatively combining the aforementioned PFMMD version of monomer 1504 where R_{f}═F with chlorotrifluoroethylene (CTFE) 1514 forms the copolymer poly(PFMMD-co-CTFE) 1515r or in shorthand as P(PFMMD-co-CTFE). Combining the PFMDD version of monomer 1504 where Rf═CF₃ with chlorotrifluoroethylene (CTFE) 1514 forms the copolymer poly(PFMDD-co-CTFE) 1515r or in shorthand as P(PFMDD-co-CTFE). Although the generic structure for both copolymers with radical R_{f} is labelled as 1515r, the specific instance P(PFMMD-co-CTFE) where R_{f}═F is numbered as 1515p and where the copolymer P(PFMDD-co-CTFE) where Rf═CF₃ is numbered as 1515m.

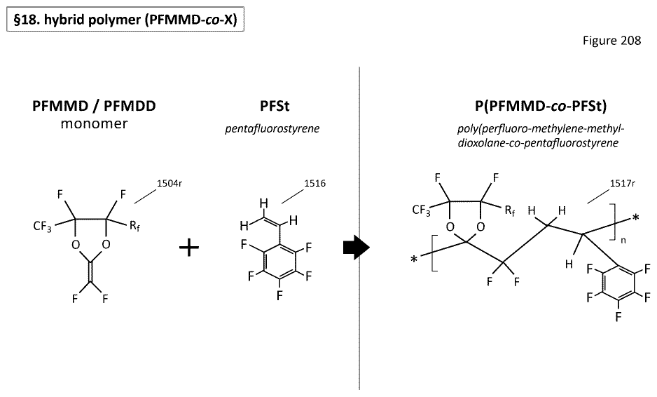

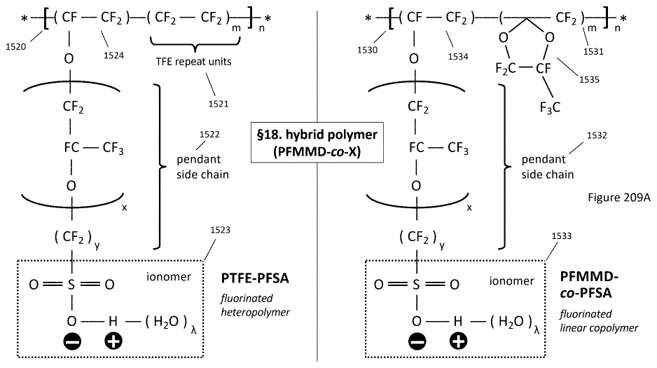

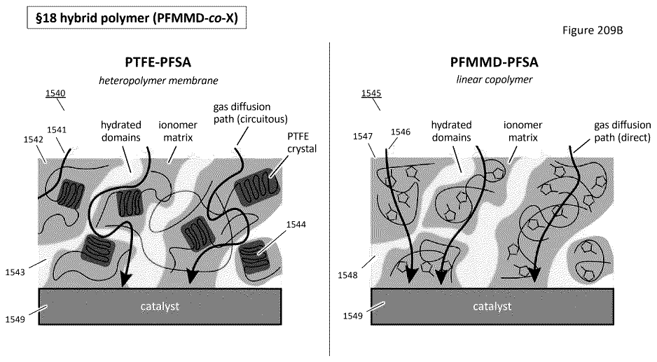

Unfortunately, perfluorodioxolane polymers forming amorphous glassy membranes while good for gas separation, are neither catalytic nor ionomeric and not useful for electrolysis, in dialysis, or in fuel cells. As such, process and structural modifications are necessary to adapt these polymers for electrochemical applications. As shown in FIG. 208, the same PFMMD monomer 1504r with radical R_{f} can also be combined with a polystyrene monomer such as pentafluorostyrene (PFSt) 1516 to form copolymer poly(PFMD-co-PFSt) 1517r with shorthand notation P(PFMD-co-PFSt), also neither catalytic nor ionomeric. Although the generic structure for both copolymers with radical Rf is labelled as 1517r, the specific instance P(PFMMD-co-PFSt) where R_{f}═F is numbered as 1517p and where the copolymer P(PFMDD-co-PFSt) where Rf═CF₃ is numbered as 1517m.

FIG. 209A contrasts PFSA-PTFE heteropolymer 1520 to the PFMMD-co-PFSA copolymer 1530. As shown, PFSA-PTFE heteropolymer 1520 comprises TFE repeated units 1521 and segment 1524 attached to pendant 1522 and ionomer 1523. By contrast, PFMMD-co-PFSA copolymer 1530 includes aromatic fluorocarbon 1531 in repeat segment 1531 with segment 1534 attached to pendant 1532 and ionomer 1533. By replacing TFE units 1521 with aromatic ring 1535, PFMMD-co-PFSA copolymer 1530 provides better gas and charge transport than PTFE based mainchains.

These benefits of an amorphous are illustrated schematically in FIG. 209B, comparing the two membrane types—the PFSA-PTFE heteropolymer 1540 and PFMMD-co-PFSA copolymer 1545. In PFSA heteropolymer 1540, ionomeric matrix 1542 comprising a PFSA-PTFE polymeric backbones formed atop catalyst layer 1549 cluster together to form crystalline structures 1544 with gas transport channels 1541 and hydrated channels 1543. In contrast, PFSA-PFMMD copolymer 1545 comprising ionomeric matrix 1547 integrating PMMD polymeric backbones formed atop catalyst layer 1549 do not cluster together to form crystalline structures, but instead form unimpaired gas transport channels 1546 and hydrated channels 1548.

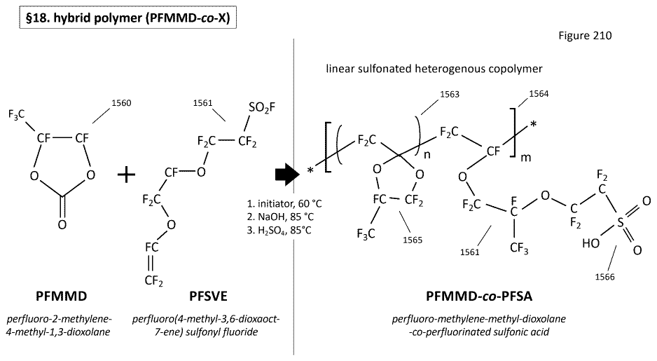

Shown in FIG. 210, one exemplary process for the synthesis of a PFMMD-co-PFSA involves the combination of PFMMD 1560 with perfluoro(4-methyl-3,6-dioxaoct-7-ene) sulfonyl fluoride (PSVE) 1561. Sequentially, the process combining (a) initiation at 60° C., (b) NaOH at 85° C., and (c) H₂SO₄ at 85° C. results in the linear fluorinated heterogenous copolymer PFMMD-co-PFSA 1564 comprising ionomer 1566 and PFMMD segment 1563. PFMMD used in gas separation membranes may also be blended with perfluoropolyether (PFPE) to form a copolymer PFMMD-co-PFPE (not shown) to enhance the operating temperature range of the membrane.

Made in accordance with this invention a new class of linear copolymer is described comprising a tri-copolymer of perfluoro (methylene-r) dioxolane copolymers with perfluorosulfonic acid (PFSA). The benefits of the new membranes are numerous. Advantages of the new tri-copolymers include:
compared to other perfluoro (methylene-r) dioxolane (PFMD) homopolymers and copolymers, the new tri-copolymer membranes are ionomeric where PFMDs are not because they contain a conductive sulfonic group 1566
the ionomeric group in the new tri-copolymer can optionally bond to various catalytic groups including metal-organic frameworks (MOFs) and other permanent fillers rendering the membrane useful for catalysis and filtering,
compared to pristine perfluorosulfonic acid (PFSA), the new membrane is mechanically stronger and less susceptible to swelling and water logging, and
compared to PFSA-PTFE heteropolymers, the amorphous portions of the film offer superior gas transport and higher conductivity than the semi-crystalline portions of a PTFE supported ionomer.

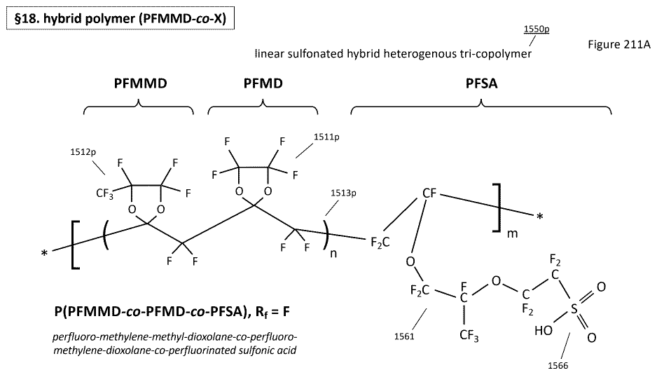

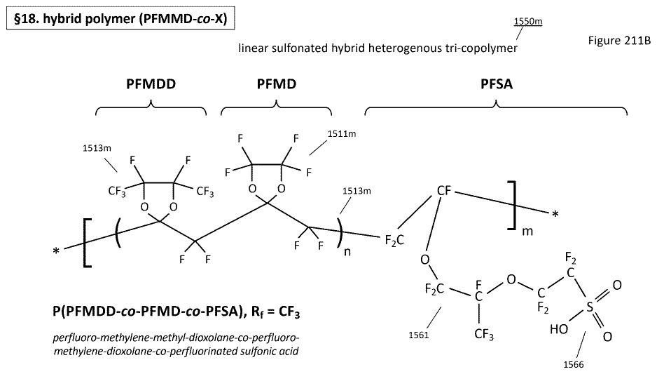

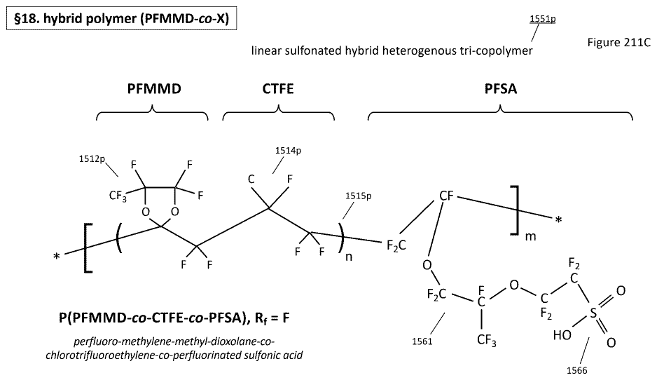

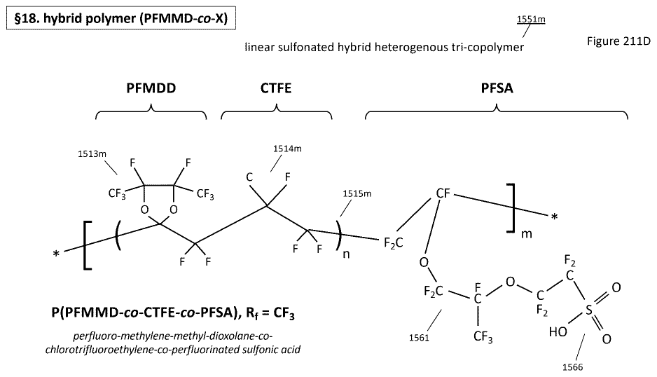

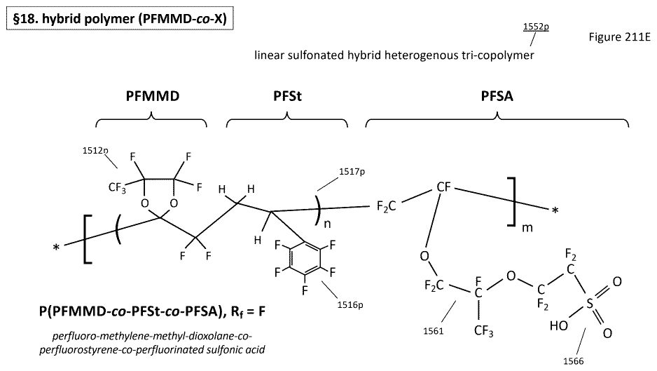

One variant of the PTFE-free tri-copolymer shown in FIG. 211A comprises a copolymer 1513p consisting of perfluoro-2-methylene-4-methyl-1,3-dioxolane (PFMMD) 1512p and perfluoro-2-methylene-1,3-dioxolane (PFMD) 1511p forming a linear copolymer with perfluorosulfonic acid (PFSA) containing pendant 1561 and ionomer 1566. Although ionomer 1566 is depicted as sulfonic acid (SO₃H), other acids such as phosphoric acid (PA) may be substituted depending of the electrolyte chemistry desired. Together they form a new ionomeric membrane comprising the hybrid tri-copolymer P(PFMMD-co-PFMD-co-PFSA) 1550p offering superior mechanical strength, good porosity, resilience to swelling, and improved conductivity.

Another variant of the PTFE-free tri-copolymer shown in FIG. 211B includes a copolymer 1513m of perfluoro-2-methylene-4,5-dimethyl-1,3-dioxolane (PFMDD) 1513m and perfluoro-2-methylene-1,3-dioxolane (PFMD) 1511m forming a linear copolymer with perfluorosulfonic acid (PFSA) containing pendant 1561 and ionomer 1566. Although ionomer 1566 is depicted as sulfonic acid (SO₃H), other acids such as phosphoric acid (PA) may be substituted depending of the electrolyte chemistry desired. Together they form a new ionomeric membrane comprising the hybrid tri-copolymer P(PFMDD-co-PFMD-co-PFSA) 1550m offering superior mechanical strength, good porosity, resilience to swelling, and improved conductivity.

A second category of the PTFE-free tri-copolymers shown in FIG. 211C comprises a copolymer 1515p consisting of perfluoro-2-methylene-4-methyl-1,3-dioxolane (PFMMD) 1512p and chlorotrifluoroethylene (CTFE) 1514p forming a linear copolymer with perfluorosulfonic acid (PFSA) containing pendant 1561 and ionomer 1566. Although ionomer 1566 is depicted as sulfonic acid (SO₃H), other acids such as phosphoric acid (PA) may be substituted depending of the electrolyte chemistry desired. Together they form a new hybrid tri-copolymer ionomeric membrane P(PFMDD-co-CTFE-co-PFSA) 1551p offering superior mechanical strength, good porosity, resilience to swelling, and improved conductivity.

Another PTFE-free tri-copolymer shown in FIG. 211D comprises a copolymer 1513m of perfluoro-2-methylene-4,5-dimethyl-1,3-dioxolane (PFMDD) 1515m and chlorotrifluoroethylene (CTFE) 1514m forming a linear copolymer with perfluorosulfonic acid (PFSA) containing pendant 1561 and ionomer 1566. Although ionomer 1566 is depicted as sulfonic acid (SO₃H), other acids such as phosphoric acid (PA) may be substituted depending of the electrolyte chemistry desired. Together they form a new hybrid tri-copolymer ionomeric membrane P(PFMDD-co-CTFE-co-PFSA) 1550m.

A third category of the PTFE-free tri-copolymers is shown in FIG. 211E comprising a copolymer 1517p consisting of perfluoro-2-methylene-4-methyl-1,3-dioxolane (PFMMD) 1512p and pentafluorostyrene (PFSt) 1516p forming a linear copolymer with perfluorosulfonic acid (PFSA) containing pendant 1561 and ionomer 1566. Although ionomer 1566 is depicted as sulfonic acid (SO₃H), other acids such as phosphoric acid (PA) may be substituted depending of the electrolyte chemistry desired. Together they form a new hybrid tri-copolymer ionomeric membrane P(PFMMD-co-PFSt-co-PFSA) 1552p offering superior mechanical strength, good porosity, resilience to swelling, and improved conductivity.

Another PTFE-free tri-copolymer shown in FIG. 211F comprises a copolymer 1513m of perfluoro-2-methylene-4,5-dimethyl-1,3-dioxolane (PFMDD) 1513m and pentafluorostyrene (PFSt) 1516p forming a linear copolymer with perfluorosulfonic acid (PFSA) containing pendant 1561 and ionomer 1566. Although ionomer 1566 is depicted as sulfonic acid (SO₃H), other acids such as phosphoric acid (PA) may be substituted depending of the electrolyte chemistry desired. Together they form a new hybrid tri-copolymer ionomeric membrane P(PFMDD-co-PFSt-co-PFSA) 1552m.

Made in accordance with this invention, the tri-copolymers of FIGS. 211A-211F constitute six new polymeric moieties of perfluoro-methylene-dimethyl polymers functionalized into ionomers for electronic applications for which PFMMD and its chemical siblings are incapable. Functionalized ionomeric copolymer described herein comprise any linear copolymer of PFMMD, PDMDD, PFMD, CTFE, and/or PFSt in combination with an ionomer such as PFSA with sulfonic acid, or phosphoric acid, boric acid, or others.

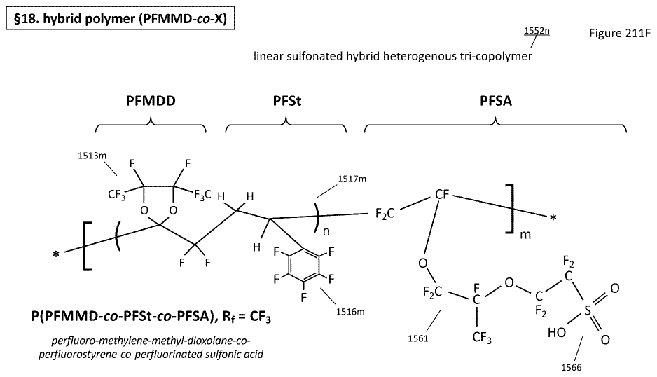

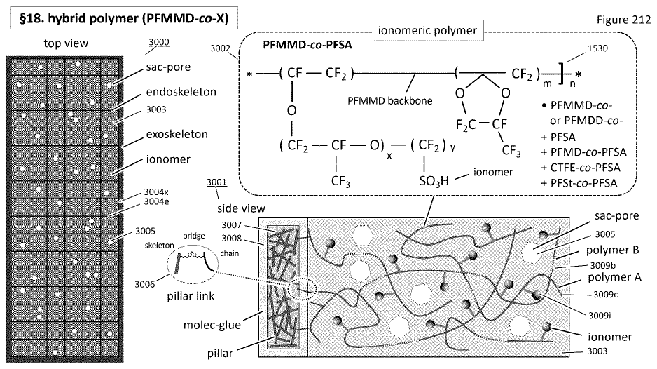

In summary membrane top view 3000 and membrane side view 3001 in FIG. 212 illustrate a variety of elements of ionomeric polymer 3002 made in accordance with this invention, including separately or in combination inventive matter comprising
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise a perfluoro-2-methylene-4-methyl-1,3-dioxolane (PMMD) backbone 1309c and perfluoro(4-methyl-3,6-dioxaoct-7-ene) sulfonyl fluoride (PFSA) 1009b to form linear methylated copolymer PFMMD-co-PFSA 1564 optionally blended with other homopolymers, heteropolymers, copolymers, including perfluoro-2-methylene-4,5-dimethyl-1,3-dioxolane (PFMDD), chlorotrifluoroethylene (CTFE), and/or pentafluorostyrene (PFSt); thereby controlling varying degrees of film crystallinity and anisotropy;
where the listed copolymers may be used for gas separation irrespective of the inclusion of PFSA in the polymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups; or a phosphoric acid or boric acid group;
where ionomeric polymer 3002 may include ionic fillers (not shown)I;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table describes various structural elements of the perfluoro-2-methylene-4,5-dimethyl-1,3-dioxolane (PFMDD) and methylene-methyl-dioxolane copolymers (PMMD) backbone class of membranes including perfluorinated sulfonic acid (PFSA), PFMD, chlorotrifluoroethylene (CTFE), and pentafluorostyrene (PFSt) compounds:

| ionomer | structure | endoskeleton | solvents, X-L | fillers |
|---|---|---|---|---|
| §18. methylene-methyl- | hybrid | polymers: PVDF, PU, | solv: DMF, HFB, | sac filler, CNTs, |
| dioxolane copolymers | PFMMD | PS, PFMD, PFMMD, | DEC, PVA. | oxides, POSS, |
| PFMMD-co-PFSA | copolymers | PMMA, PFMDD. | X-L: FBzO, | NPs, MOFs, PIL |
| PFMDD-co-PFSA | | pillars: reinforcing | FDTBO, PFDMO. | |
| PFMD-co-PFSA | | fillers (C-filler, CNTs). | | |
| PFMMD-co-PFMD-co-PFSA | | | | |
| PFMDD-co-PFMD-co-PFSA | | | | |
| PFMD-co-CTFE-co-PFSA | | | | |
| PFMMD-co-CTFE-co-PFSA | | | | |
| PFMDD-co-CTFE-co-PFSA | | | | |
| PFMD-co-PFSt-co-PFSA | | | | |
| PFMMD-co-PFSt-co-PFSA | | | | |
| PFMDD-co-PFSt-co-PFSA | | | | |

Section § 3 describes pristine heteropolymer IEMs of PMMDD and PFSA, whereas the above table describes glassy amorphous hybrid IEMs of composite reinforced membranes comprising copolymers of PFMMD related polymers including PFMMD, PDMDD, PFMD, or any other polymer such as PFSt or CTFE having large groups that interfere with polymer crystallinity. Although any number of endoskeletal materials may be used in pillar construction, molecules of similar composition to the membrane such as PFMD, PFMMD, PFMDD, PMMA, PU, and PVDF offer better bonding strength then hydrophobic perfluorinated materials.

Exemplary solvents include dimethylformamide (DMF), hexafluorobenzene (HFB), and diethyl carbonate (DEC). During synthesis, cross linking agents include perfluorodibenzoyl peroxide (FBzO)₂ or simply FBzO, perfluoro-di-tert-butyl peroxide (FDTBO), and perfluoro-dimethyl-dioxolane (PFDMO). Membranes fillers and dopants were described previously and for brevity's sake, will not be repeated here. Applications of glassy amorphous membranes of copolymers include gas separation membranes and proton exchange membranes for hydrogen fuel cells.

### § 19. Functionalized Hybrid Phenylenediamine (PDD) Copolymer IEMs.

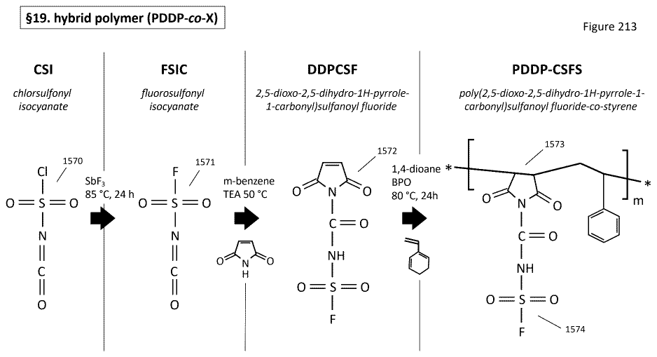

Another category of glassy or amorphous copolymers are those related to poly(dioxo-dihydro) compounds. The synthesis of one such compound PDDP-CSFS is shown in FIG. 213 in which chlorsulfonyl isocyanate (CSI, CISI) 1570 is treated for 24b at 85° C. by antimony trifluoride (SbF₃, Swarts' reagent) to produce fluorosulfonyl isocyanate 1571, which is subsequently treated by methylbenzene (MeBz) and triethylamine (TEA) to yield 2,5-dioxo-2,5-dihydro-1H-pyrrole-1-carbonylsulfanoyl fluoride (DDPCSF) 1572.

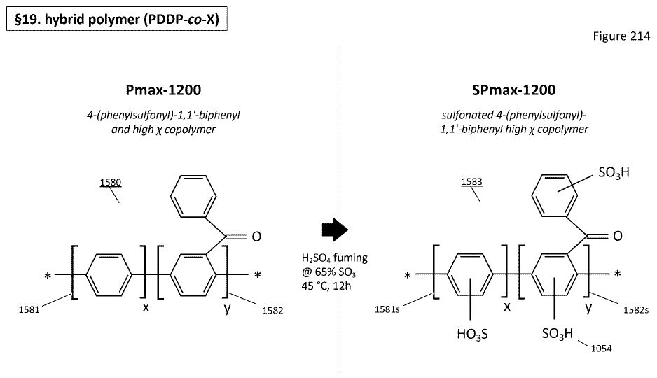

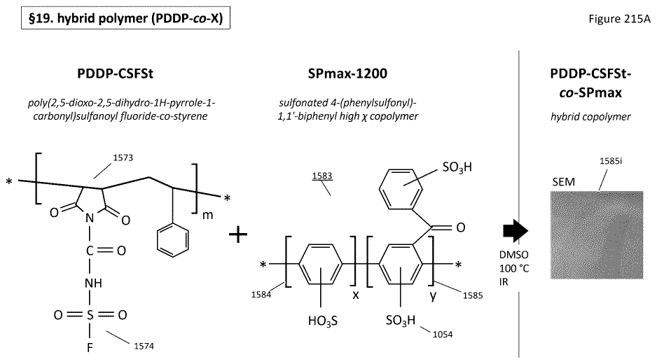

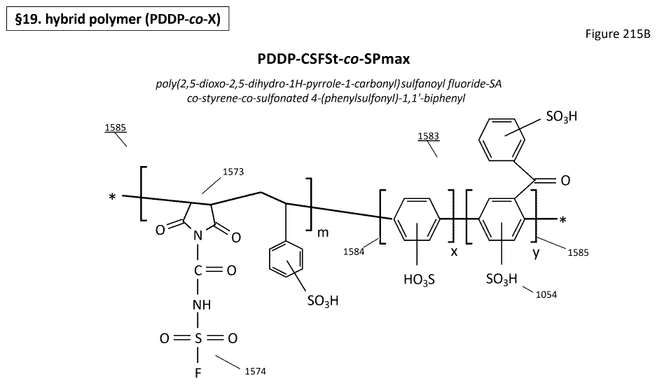

Subsequent treatment in stabilizer 1,4-dioxane and benzoyl peroxide (BPO) for 24 h at 80° C. produces the linear copolymer poly(2,5-dioxo-2,5-dihydro-1H-pyrrole-1-carbonyl) sulfonyl fluoride-co-styrene (PDDP-CSF-co-St, PDDP-CSFS) 1574 with sulfonic acid ionomer 1574. In a parallel process shown in FIG. 214, the high-X copolymer 4-(phenylsulfonyl)-1,1′-biphenyl (Pmax-100) 1582 containing benzene group 1581 and the orthogonal group sulfone 1582 is converted by fuming in sulfuric acid (H₂SO₄) for 12 h at 45° C. into the sulfonated high-X copolymer 4-(phenylsulfonyl)-1,1′-biphenyl (SPmax-1200) 1583 comprising the sulfonated phenyl groups 1581s and 1582s.

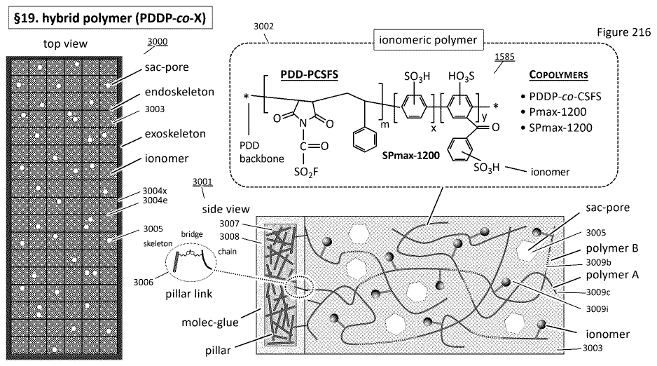

FIG. 215A illustrates a reaction of previously described molecules comprising poly(2,5-dioxo-2,5-dihydro-1H-pyrrole-1-carbonyl)sulfanoyl fluoride-co-styrene (PDDP-CSFS) 1573 including sulfonyl fluoride side group 1574 and high-X copolymer sulfonated 4-(phenylsulfonyl)-1,1′-biphenyl (SPMax-1200) 1583, wherein treatment by the organic solvent dimethylsulfoxide (DMSO) at 100° C. in infrared light, a hybrid linear copolymer PDDP-CSFS-co-SPmax 1885 is synthesized as shown by SEM image 1885i. The chemical representation of PDDP-CSFS-co-SPmax 1885 is illustrated in FIG. 215B.

Membrane top view 3000 and membrane side view 3001 in FIG. 216 illustrate a variety of elements of glassy ionomeric polymer 3002 comprising poly(dioxo-dihydro) and poly(dioxo-dihydro-pyrrole) compounds made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric copolymer 3002 is a hybrid of PDDP-CSFS mainchain 3009c comprising 2,5-dioxo-2,5-dihydro-1H-pyrrole-1-carbonyl)sulfamoyl fluoride and a highly-branched high-X copolymer 3009b such as Pmax-1200 1580 or SPMax-1200 1583 optionally blended with other homopolymers, heteropolymers, copolymers, thereby controlling varying degrees of film crystallinity and anisotropy to form hybrid copolymer blend 1585;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers (not shown)I;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

Whereas section § 3 describes pristine heteropolymer IEMs of PDD and PFSA, the characteristics of PDD and PDDP copolymer membranes are described in the below table:

| ionomer | structure | endoskeleton | solvents, X-L | fillers |
|---|---|---|---|---|
| §19. phenylenediamine | hybrid PDD | polymers: PAm, PU, | solv: DMF, HFB, | sac filler, CNTs, |
| PDD copolymers | copolymers | PI, aramid fiber, EPX | DEC, PVA. | oxides, POSS, |
| PDDP-CSFS | | pillars: reinforcing | X-L: FBzO, | NPs, MOFs, PIL |
| PDDP-CSFS-co-SPmax | | fillers (C-fiber, CNTs) | FDTBO, PFDMO. | |

Copolymer ionomers comprise phenylenediamine linear chains copolymerized with carbonyl-sulfanoyl fluoride, and sulfonated phenylsulfonyl biphenyl monomers. Exemplary solvents include dimethylformamide (DMF), hexafluorobenzene (HFB), and diethyl carbonate (DEC). During synthesis, cross linking agents include perfluorodibenzoyl peroxide (FBzO)₂ or simply FBzO, perfluoro-di-tert-butyl peroxide (FDTBO), and perfluoro-dimethyl-dioxolane (PFDMO). Membranes fillers and dopants were described previously and for brevity's sake, will not be repeated here. Applications of glassy amorphous membranes of copolymers include gas separation membranes and proton exchange membranes for hydrogen fuel cells.

### § 20. Functionalized Hybrid Phenyl Copolymer IEMs.

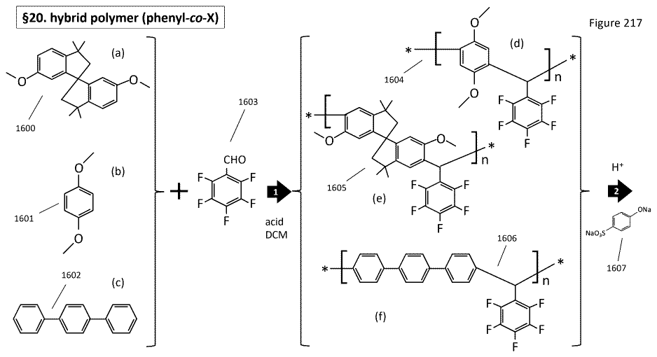

Linear chains of phenyl may also be used to form ionomeric copolymers, especially in the form of phenyl-co-alkanes and phenyl-co-aldehydes. An alkane is a molecule incorporating an acyclic, i.e. open chain saturated hydrocarbon, comprising hydrogen and carbon atoms arranged in a tree structure in which all the carbon-carbon bonds are single. In phenyl-co-alkanes linear chain polymers, alkanes form the linkage between various phenyl moieties. For example, in FIG. 217 polymeric precursors include (i) spiro-monomer SBI 1600, (ii) p-dimethoxybenzene 1601, and (iii) p-terphenyl 1602. When reacted with pentafluorophenyl group 1603 in step 1 with acid and dichloromethane (DCM), the products comprise three sulfonated phenyl-alkane polymers with one off-chain fluorophenyl group plus (iv) one on-chain phenyl group 1604, (v) two on-chain phenyl group 1605, and (vi) three on-chain phenyl group 1606. In step 2, the intermediate products are treated with sodium 4-hydroxybenzenesulfonate 1607 followed H⁺ annealing.

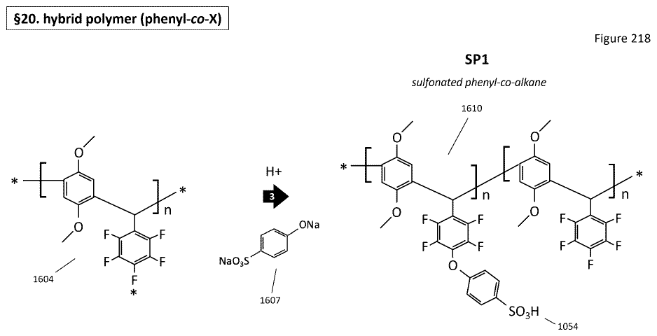

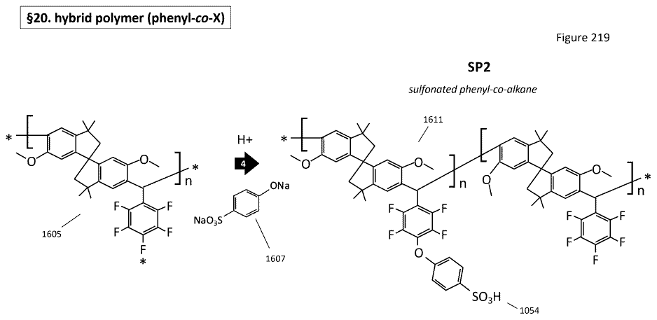

As shown in step 3 of FIG. 218 treatment of phenyl-alkane 1604 having one on-chain phenyl by sodium 4-hydroxybenzenesulfonate 1607 followed H⁺ annealing results in a sulfonated phenyl-co-alkane SP1 1610 where the sulfonic group attaches to every other fluorophenyl group. Step 4 of FIG. 219 illustrates treatment of phenyl-alkane 1605 having two on-chain phenyl groups by sodium 4-hydroxybenzenesulfonate 1607 followed H⁺ annealing results in a sulfonated phenyl-co-alkane SP2 1611 where the sulfonic group attaches to every other fluorophenyl group.

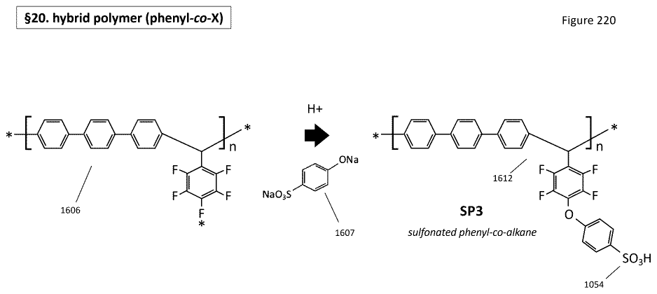

Step 5 of FIG. 220 illustrates treatment of phenyl-alkane 1606 having three on-chain phenyl groups by sodium 4-hydroxybenzenesulfonate 1607 followed H⁺ annealing results in a sulfonated phenyl-co-alkane copolymer SP3 1612 where the sulfonic group attaches to every fluorophenyl group.

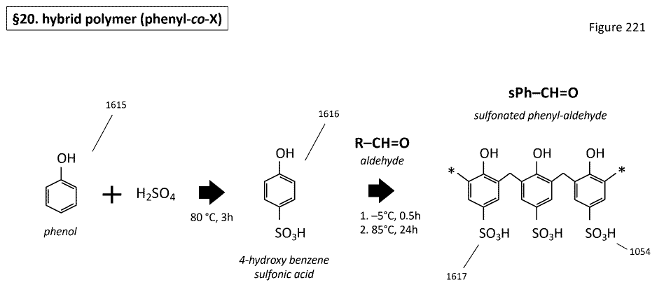

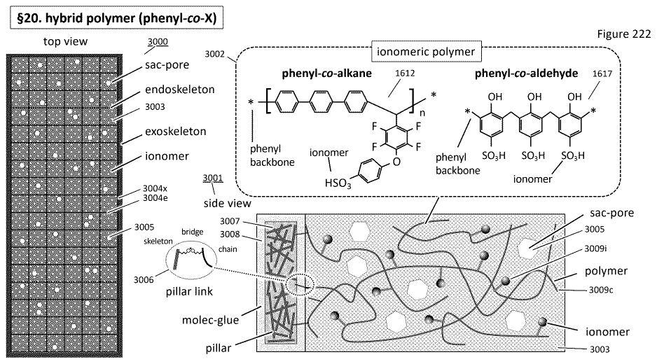

An exemplary process for formation of a phenol sulfonic acid membrane is depicted in FIG. 221 where phenol group 1605 is mixed with sulfuric acid (H₂SO₄) at 80° C. for 3 h to form 4-hydroxy benzene sulfonic acid 1616. The compound is subsequently treated by an aldehyde having the molecular structure R-CH═O at 5° C. for 0.5 h followed by 85° C. for 24 h to produce the sulfonated phenyl-aldehyde sPh-CH═O 1607. As shown every phenol ring is decorated by sulfonic acid.

Membrane top view 3000 and membrane side view 3001 in FIG. 222 illustrate a variety of elements of ionomeric copolymers 3002 comprising phenyl mainchains made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 is a phenol compound such as phenyl-alkane 1612 or phenol-aldehyde 1617 optionally blended with other homopolymers, heteropolymers, copolymers, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers (not shown)I;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table describes characteristics of hybrid phenyl based ionomeric copolymers, which may be subdivided into two classes, namely alkane and aldehydes, describing the functional groups attached to the aromatic ring. Easily functionalized by sulfonic acid, hybrid phenyl copolymers comprise linear copolymers alternating phenyl or phenol groups with either alkane or aldehyde strands.

| ionomer | structure | endoskeleton | solvents, X-L | fillers |
|---|---|---|---|---|
| §20. phenyl copolymers | hybrid Ph | polymers: EPX, PU, | solv: EtOH, IPA, ace, | sac filler, CNTs, |
| sPh-alkane | copolymers | PI, PS, PVA, PAm, PAc | MIBK, ETAC, TCM, tol | oxides, POSS, |
| sPh-aldehyde | | pillars: reinforcing | X-L: Ziegler-Natta | NPs, MOFs, PIL |
| | | fillers (C-fiber, CNTs) | catalyst, BF₃, SnCl₄, | |
| | | | SbF₃, TiCl₄. | |

Endoskeletal polymers able to bond to phenyl aldehydes include epoxy resins (EPX) through covalent bonding between aldehyde groups; polyurethanes (PU) through hydroxyl to polyol bonds; polystyrene (PS, PSt) which is an alkylbenzene able to bond to alkanes; polyacrylates (PAc) made from acrylic acids able to form ester linkages with alcohol groups on a phenyl-alkane chain; polyvinyl (PVA) reacting with aldehyde groups of phenyl-aldehydes to form hemiacetals or acetals; polyimides (PI) synthesized from diamines and diacids able to form amide bonds to amino group or a carboxylic acid group on phenyl-alkane or phenyl-aldehyde chains.

Solvents of the phenyl group in phenol based polymers include ethanol (EtOH, CH₃CH₂OH); IPA (2-propanol, isopropyl alcohol); acetone (ace, 2-propanone, dimethyl ketone), MIBK (4-methylpentan-2-one, (CH₃)_{L}CHCH₂C(O)CH₃)); ethyl acetate (ETAC, EtOAc, ethyl ethanoate, C₄H₈O₂); chloroform (TCM, trichloromethane, CHCl₃); and toluene (tol, toluol, C₆H₅CH₃, PhCH₃). Polymerization of alkanes can be performed using Ziegler-Natta catalysts prepared by reacting certain transition metal halides with organometallic reagents such as alkyl aluminum, lithium and zinc reagents. Aldehyde polymerization is catalyzed by boron trifluoride (BF₃), tin tetrachloride (SnCl₄), antimony trifluoride (SbF₃), and titanium tetrachloride (TiCl₄). Membranes fillers and dopants were described previously and for brevity's sake, will not be repeated here.

### § 21. Functionalized Hybrid Polystyrene (PS, PSt) Copolymer IEMs.

While section § 10 describes pristine polyolefin sulfonated polystyrene membranes, this section describes copolymers of polystyrene (PS, PSt) used to form hybrid IEMs. As described, polystyrene can form copolymers with itself through multi-chain cross linking, linear copolymers with polystyrene sulfonates, grafted polymers with perfluoroalkoxy alkanes, copolymers with polyurethane thermoplastics, and linear mainchains comprising both rigid and flexible polystyrene segments.

Like many polyolefins, pure polystyrene is not a good electrical conduction, but can be functionalized by sulphonic acid or other acid groups to form ionomers, or functionalized by bonded metallic groups, fillers, or dopants to form catalytic groups. Made in accordance with this invention, both ionomeric and catalytic IEMs of polystyrene can be rendered useful for application of filtering, purification, electrolysis, and membrane fuel cells.

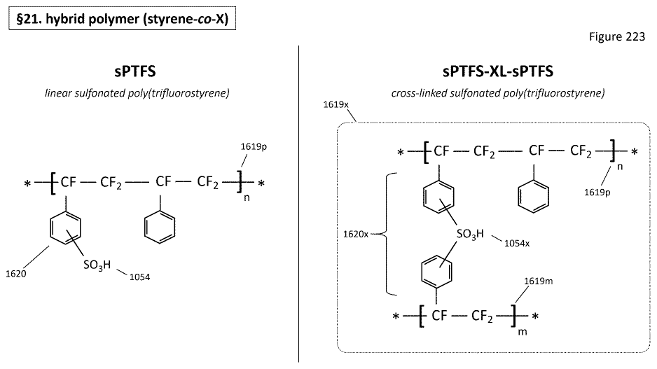

FIG. 223 depicts two topological variations of functionalized polystyrene. Specifically linear sulfonated poly(trifluorostyrene) (sPTFS) 1619s illustrates a linear fluorocarbon mainchain with sulfonated phenyl groups substituted for fluorine on the backbone. This bonding configuration is reminiscent of PFSA except that fluorocarbon pendants have been replaced by an aromatic ring with an attached sulfonic acid (SO₃H) 1054 group. In this sense, the sPTFS behaves like a short sidechain PFSA ionomer except that the aromatic ring increases film porosity somewhat by disturbing matrix crystallinity, but not as much as glassy matrices involving PFMMD or PDDP linear copolymers. Made in accordance with this invention, the lower porosity caused by the short sidechain can bae compensated by using a sacrificial filler or by doping the film with silica or other permanent filler to disrupt PSt crystallinity.

Another way to improve gas transport while increasing film strength is achieved through cross linking between or among multiple sPTFS backbones as depicted by cross-linked sulfonated poly(trifluorostyrene) (sPTFS-X) 1619. Although cross linking may involve an organic ligand such as glutaraldehyde, in other instances a shared ionomer may perform the same function through electrostatic cross linking, even if the ionomer is covalently bonded to only one PSt mainchain. For example, sPTFS-X 1619 illustrates poly(trifluorostyrene) 1619p of chain length n is bonded to a second poly(trifluorostyrene) 1619m or chain length m through an acidic cross link 1620x comprising two phenyl groups sharing a common sulfonic acid 1054x.

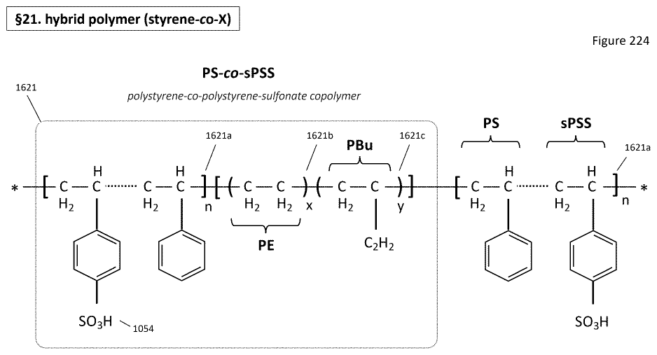

FIG. 224 illustrates the molecular structure of a styrene-ethylene blended polymeric ionomer comprising the linear copolymer unit cell 1621 of a polystyrene-co-polystyrene-sulfonate (PS-co-sPSS) copolymer including a carbon-free polystyrene backbone and a polystyrene segment 1621a linearly bound to inserts of polyethylene (PE) 1621b, and polybutylene (PBu) 1621c.

It should be noted that although nascent ethylene (H₂C═CH₂) and butylene (H₂C═CH—C₂Hₓ) contain carbon-to-carbon double bonds, in the polymeric forms secondary bonds to the polymer's mainchain eliminates the double bond by usurping the unused extra electron. As shown, polystyrene segment 1621a contains unfunctionalized polystyrene groups PS and sulfonated portions sPSS with sulphonic acid (SO₃H) 1054 attached to the aromatic ring. As such, the hybrid copolymer is referred to as polystyrene-co-polystyrene-sulfonate (PS-co-sPSS). Given the linking role of the polyethylene (PE) 1621b and polybutylene (PBu) 1621c groups, a more complete name for the copolymer is polystyrene-co-polystyrene-sulfonate-co-polyethylene-co-polybutylene (PS-co-sPSS-co-PE-PBu). The fully descriptive moniker, however is not required as the PE and PBu groups do not influence conductivity and have minimal impact of porosity.

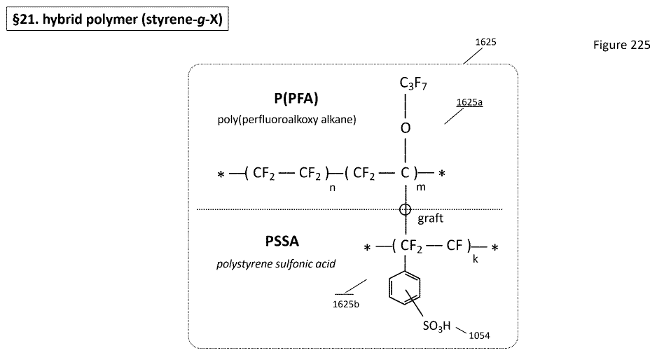

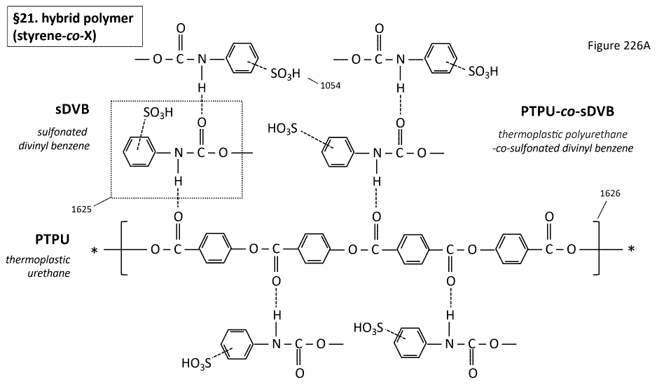

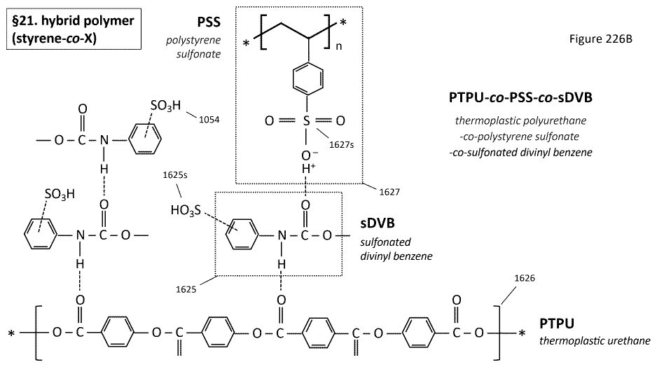

Another approach to manage strength and porosity of polystyrene ionomers is by grafting of sulfonated polystyrene to other polymer mainchains. In FIG. 225, polystyrene sulfonic acid (PSSA) 1625b is grafted onto poly(perfluoroalkoxy alkane) polymer 1625a to form a grafted copolymer poly(tetrafluoroethylene-co-perfluorovinyl ether)-graft-polystyrene sulfonic acid (PFA-g-PSSA) 1625.

Polystyrene (PSt) ionomers can also form copolymers with polyurethane (PU). As depicted in FIG. 226A illustrates comprises a poly thermoplastic urethane (PTPU) 1626 forming hydrogen bonds to sulfonated divinyl benzene (sDVB) 1625 resulting in a copolymer thermoplastic polyurethane-co-sulfonated-divinyl-benzene (PTPU-co-sDVB). FIG. 226B illustrates bonding of polystyrene sulfonate 1627 to sulfonated divinyl benzene (sDVB) 1625 via a hydrogen bond between the sulfonic acid group of PSS and the double-bonded oxygen of sDVB.

The resulting copolymer as shown is thermoplastic polyurethane-co-polystyrene sulfonate-co-sulfonated divinyl benzene (PTPU-co-PSS-co-sDVB). The hydrogen bonding of thermoplastic urethane to sulfonated polystyrene divinyl benzene has applications in electrodialysis but using embodiments of this invention can be enhanced for use in fuel cell applications.

Another benefit of TPU is its ability to control rigidity, whereas soft and hard segments imparts rubber-like and glass-like characteristics to the backbone. While soft segments include polyether or polyurethane ester (PUE) having molecular weights of 1000-3000, the hard TPU segments include complexes of polyurethane diisocyanate with diols. The combination of hard and soft segments influences mechanical film properties affecting permeation rate and selectivity in gas separation, desalination and pervaporation membranes, and gas permeability in ion exchange membranes.

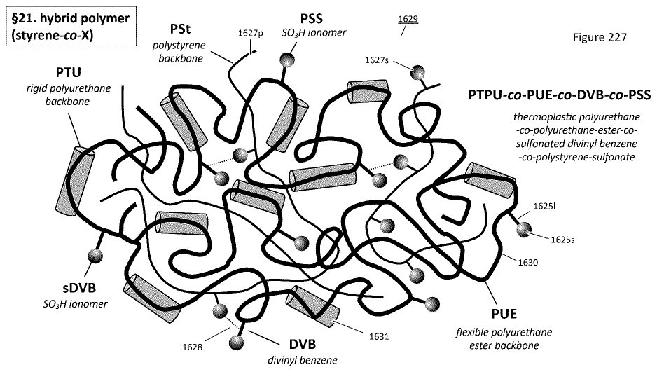

The topographical impact of blending flexible polyurethane-ester (PUE) 1630 with rigid scaffolding 1631 is depicted schematically in FIG. 227. As shown, the PTU-co-PUE linear copolymer 1630 and 1631 contains DVB ligand 1625 with sulfonated divinyl benzene groups (sDVB) 1625s. A second polymer backbone comprising polystyrene (PSt) 1627p is functionalized by sulfonic acid groups to form polystyrene sulfonate ionomers (PSS) 1627s.

The PSS ionomers 1627s further form hydrogen bonds 1628 to DVB ligands 16251 thereby facilitating cross linking between the polystyrene (PSt) 1627p mainchain and the PTU-co-PUE linear copolymer 1630 and 1631. The result is a quatre-copolymer comprising thermoplastic polyurethane-co-polyurethane-ester-co-sulfonated divinyl benzene-co-polystyrene-sulfonate or PTPU-co-PUE-co-DVB-co-PSS 1629. The membrane may also be doped with electroconductive polyaniline as a permanent filler. Polyaniline is a conducting polymer and organic semiconductor of the semi-flexible rod polymer family.

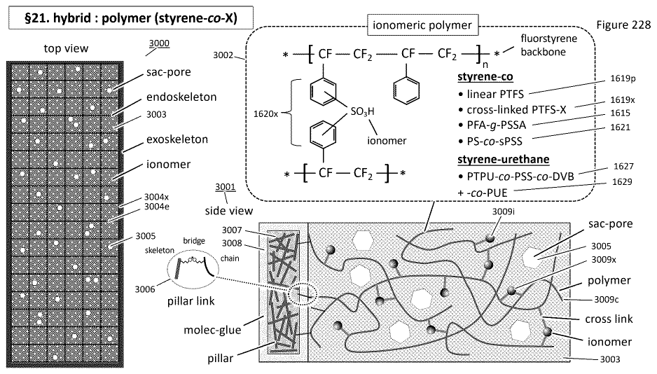

Membrane top view 3000 and membrane side view 3001 in FIG. 228 illustrate a variety of elements of ionomeric copolymer 3002 comprising thermoplastic polyurethane copolymers made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise exemplary molecules such as linear polymer trifluorostyrene (PTFS) 1619p, cross-linked polymer trifluorostyrene (PTFS) strands 1619x, poly(perfluoroalkoxy alkane) grafted onto polystyrene sulfonic acid (PFA-g-PSSA) 1621, polystyrene to polystyrene-sulfonate copolymer (PS-co-sPSS) 1621, poly(thermoplastic-polyurethane-divinylbenzene-co-polystyrene-sulfonate) aka P(TPU-co-DVB-co-PSS) 1627 optionally blended with other homopolymers such as polyurethane-ester P(TPU-co-PUE-DVB-co-PSS), heteropolymers, copolymers, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers including polyaniline (not shown) as well as other permanent fillers pf CNTs, oxides, POSS, NPs, MOFs, and PIL;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

In order to form PSt conductive ionomers, copolymers of polystyrene are beneficial to control conductivity and porosity. Examples include linear and cross linked poly(trifluorostyrene) (PTFS and PTFS-X); poly(perfluoroalkoxy alkane) grafted copolymers with polystyrene sulfonic acid (P(PFA)-g-PSSA), and polystyrene-sulfonate copolymers (PS-co-sPSS). Styrene-urethane copolymers include poly(thermoplastic-polyurethane-divinylbenzene-co-polystyrene-sulfonate) aka P(TPU-co-DVB-co-PSS) optionally blended with other homopolymers such as polyurethane-ester P(TPU-co-PUE-DVB-co-PSS). The following table describes elements of polystyrene copolymers:

| ionomer | structure | endoskeleton | solvents, X-L | fillers |
|---|---|---|---|---|
| §21A. styrene copolymers | hybrid PSt | polymers: PS-PU, | solv. PVDF, NH₄I, | sac filler, CNTs, |
| linear PTFS | copolymers | ABS, PC, PE, PP, | Na₂SO₄, DMAc, | oxides, POSS, |
| cross linked PTFS-X | | PVC, PET, PMMA | BzOH, EtOAc | NPs, MOFs, PIL, |
| P(PFA)-g-PSSA | | pillars; reinforcing | X-L: heat, (BzO)₂, | polyaniline |
| PS-co-sPSS | | fillers (C-fiber, CNTs) | (OHMe)-BnCl | |
| §21B. styrene-urethane | | | | |
| copolymer | | | | |
| PTPU-co-sDVB-co-PSS | | | | |
| PTU-co-PTUE-co-sDVB-co- | | | | |
| PSS | | | | |

Endoskeletal polymers may include polystyrene-polyurethane (PS-PU) blends; acrylonitrile butadiene styrene (ABS) which bonds to polystyrene through solvent welding dissolving both polymers and welding their surfaces together; polycarbonates (PC) bonded to polystyrene using solvent bonding or with special adhesives that bond to both polymers; polyethylene and polyproline (PE, PP) bondable to polystyrene only following surface treatments such as corona, plasma, or flame treatment whereby PSt surface energy is increased, allowing for better adhesion with adhesives or by using specialized bonding agents; polyvinyl chloride (PVC) bonding to PSt using adhesives compatible with both materials or via solvent welding; polyethylene terephthalate (PET) bonded to polystyrene using suitable adhesives; polymethyl methacrylate (PMMA) bonded to polystyrene using solvent bonding similar to ABS; or by thermoplastic elastomers (TPEs) through over-molding.

Solvents of polystyrene include polyvinyl difluoride (PVDF), ammonium iodide (NH₄I), sodium sulfate (Na₂SO₄), dimethylacetamide (DMAc), benzaldehyde (BzOH), and ethyl acetate (EtOAc). Polymerization of polystyrene is prepared by free radical addition polymerization of styrene in the presence of benzoyl peroxide (BzO)₂ as a catalyst. Post polymerization cross linking include p-hydroxymethyl benzyl chloride (OHMe-BnCl). Polyaniline is a conductive filler and dopant compatible with polystyrene. Other membranes fillers and dopants were described previously and for brevity's sake, will not be repeated here.

### § 22. Functionalized Hybrid Polysulfone (PSU, PSf) Polymer IEMs.

A superior albeit more expensive alternative to polycarbonate, polysulfone is a high temperature thermoplastic with superior hydrolytic, thermal, and oxidative stability. Containing an aryle-SO₂-aryle subunit, three forms of polysulfone comprise three moieties—polysulfone (PSU, PSf) described in this section, polyethersulfone (PES, PESU, PESf) discussed in sections § 13, § 15, § 33, § 37 and polyphenylene sulfone (PPSU).

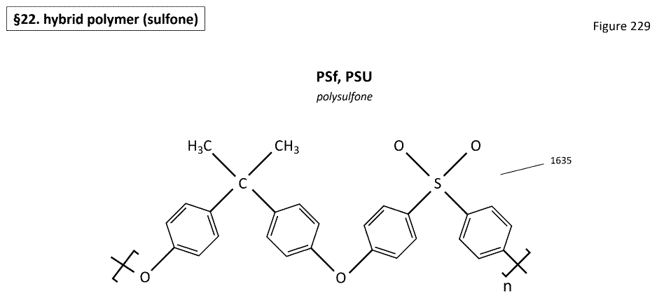

FIG. 229 illustrates a polysulfone molecule 1665 (PSU, PSf) comprising four aromatic rings alternatively linked by methylated carbon and by sulfur dioxide. On its own, polysulfone is neither ionomeric or catalytic. Given its preponderance of constituent phenyl groups, PSU can easily be functionalized by sulfur dioxide or sulfuric acid into an ionomer comprising a sulfonic acid group.

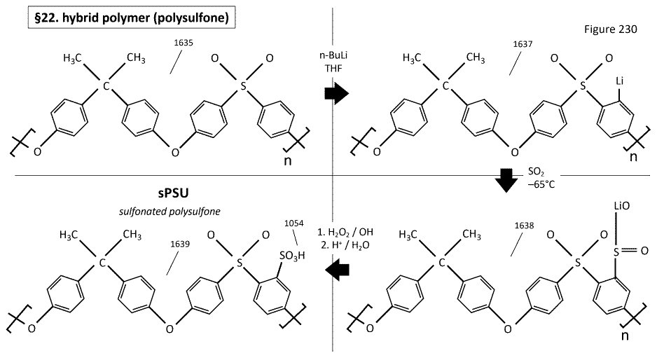

As shown in FIG. 230, functionalizing polysulfone 1665 requires several steps comprising (a) treating with nascent polysulfone with N-butyllithium (N-BuLi) and tetrahydrofuran (THF) to attach lithium to one aromatic ring forming intermediary 1637. Subsequent treatment in SO₂ cooled to −65° C. modifies the attached lithium into sulfone intermediary 1638 with a lithium oxide side-group. In the final step, the lithium oxide is functionalized into sulfonic acid (SO₃H) by treatment in hydrogen peroxide (H₂O₂), hydroxide (—OH), and hydronium ions (H₃O+), i.e. water plus H⁺.

The resulting sulfonated polysulfone (sPSU) 1639 as shown contains on average one sulfonic acid group (SO₃H) for every four aromatic rings. The molecule is considered a hybrid polymer or heteropolymer because the repeating segments on the mainchain alternate between a sulfone group and a methylated group. Because the two segments are however formed concurrently, the backbone while a heteropolymer is not classified as a copolymer.

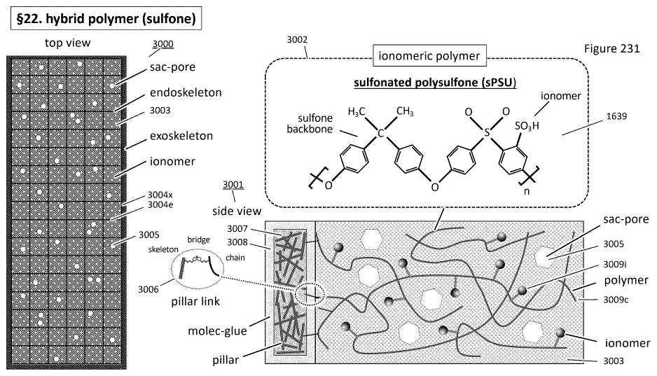

In summary, membrane top view 3000 and membrane side view 3001 in FIG. 231 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 is polysulfone (PSU, PSf) 1639 optionally blended with other homopolymers, heteropolymers, copolymers, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers (not shown)I;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR₄⁺; phenolic hydroxyl groups —OH, or any other acidic group which easily ionizes to donate conducting cations of H⁺, Na⁺, or K⁺ into the solid electrolyte, and finally
where the combination of the endoskeletal pillars and the membrane coating are used to seal in any ionic liquid doping to prevent seepage, leakage, or IL depletion.

The following table describes the construction of polysulfone heteropolymer hybrid membranes:

| ionomer | structure | endoskeleton | solvents, X-L | fillers |
|---|---|---|---|---|
| §22. polysulfone | hybrid PSf | polymers: PEEK, PEI, | solv: NMP, DMAc, | sac filler, CNTs, |
| heteropolymers | polymers | PBI, PAm, PE, PP, | DMF, CHCl₃, CdCL₂ | oxides, POSS, |
| sPSf-PSf | | PC, ABS, PU | X-L: FeCl₃, SbCl₅, | NPs, MOFs, PIL |
| | | pillars; reinforcing | BMP, TPO, TMPTA | |
| | | fillers (C-fiber, CNTs) | | |

Linear heteropolymers of sulfonated polysulfone (sPSU, sPSf) and un-sulfonated polysulfone (PSU, PSf) represent the cost common instances of hybrid PSf copolymers. Endoskeletal pillar materials compatible with polysulfone membranes include: polyether ether ketone (PEEK) and polyetherimide (PEI) bonded to polysulfone using high-performance adhesives resistant to high temperatures; and polyamide (PAm) bondable to PSf using adhesives such as epoxy resins or polyurethane adhesives pursuant to surface preparation such as roughening.

Polyethylene (PE) and polypropylene (PP) although difficult to bond may use epoxies or modified acrylic bonding subsequent to surface treatments such as corona and plasma treatments used to increase the surface energy and improve adhesion; polycarbonate (PC) bondable to polycarbonate using adhesives that are compatible with both materials such as certain epoxies or solvent-based adhesives; acrylonitrile butadiene styrene (ABS) bondable to polysulfone using adhesives like cyanoacrylates, epoxies, or solvent-based adhesives after suitable surface preparation; polyurethanes (PU) using adhesives that form strong bonds with both materials, including polyurethane adhesives and some epoxies; and polybenzimidazole (PBI) with suitable adhesives.

Solvents used in forming polysulfone polymers include N-methylpyrrolidone (NMP), N,N-dimethylacetamide (DMAc), N,N-dimethylformamide (DMF), chloroform (CHCl₃), dimethyl sulfoxide (DMSO), or cadmium chloride (CdCL₂). Catalysts and reagents beneficial in polymerizing polysulfone membranes and cross linking them to other polymers include Friedel-Crafts catalysts such as ferric chloride (FeCl₃, iron (III) chloride) or antimony pentachloride (SbCl₅). Cross linking of polysulfone can be performed by 4,4′-trimethylene bis(1-methylpiperidine) (BMP) or by photoinduced cross linking in 2,4,6-trimethylbenzoyl-diphenyl-phosphine oxide (TPO) and trimethylolpropane tri-acrylate (TMPTA). Membranes fillers and dopants were described previously and for brevity's sake, will not be repeated here.

### § 23. Functionalized Hybrid Polyamide Sulfonimide (PAm-Co-Sim) Copolymer IEMs.

Another category of ionomeric polymer is functionalized polyamides. Polyamides are polymers formed of repeating units linked by intervening amide bonds facilitating good thermal and chemical resistance as well as controlled crystallinity. A polymer of amide, not to be confused with polyimide, comprises a general structure a backbone of N—C—R where the nitrogen form a single H-N bond and the oxygen forms a C═O double bond to the on-chain carbon, or more simply as the chemical formula (OC)—(NH). Polyamides applicable for membranes comprise a subgroup called aramids or aromatic polyamides—amide polymers that contain phenyl rings in their repeating units. One motivation for forming ionomeric polyamides is the elimination of sulfonic acid groups (SO₃H) found to be subject to degradation by hydrogen peroxide (H₂O₂) present in an IEM matrix.

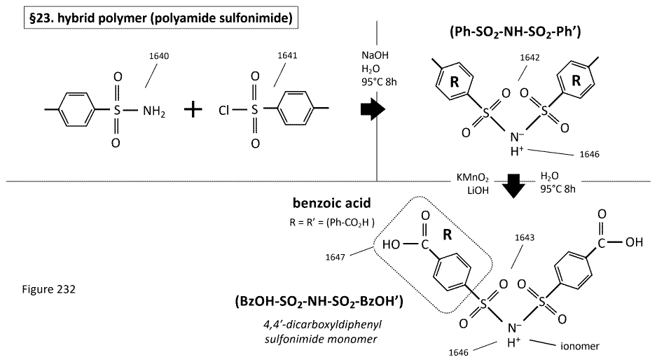

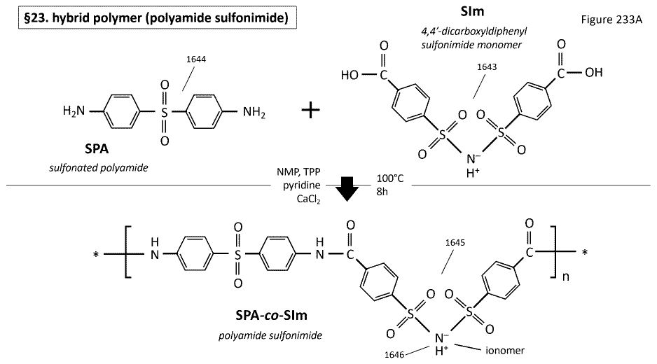

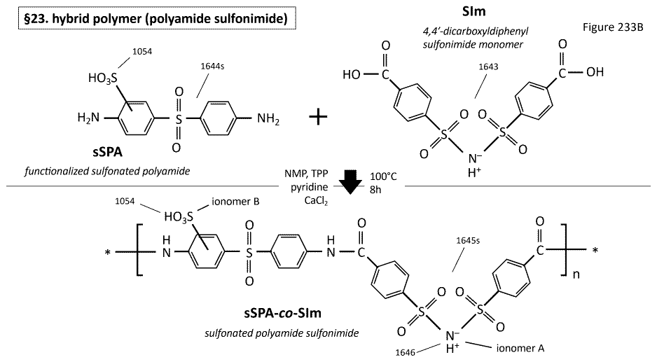

An exemplary process for formation of functionalized polyamide is illustrated in FIG. 232, where reactants 1640 and 1641 are combined with sodium hydroxide (NaOH) and water (H₂O) at 95° C. for 8 h resulting in diphenyl sulfonimide monomer 1642 having a chemical structure (Ph-SO₂—NH—SO₂-Ph′) with ionic (N—H⁺) group 1646. Subsequent treatment in potassium manganate (KMnO₂), lithium hydroxide (LiOH), and water at 95° C. for 8 h converts the phenyl group into benzoic acid 1647 resulting in the monomer 4,4′-dicarboxyldiphenyl sulfonimide of the form (BzOH-SO₂—NH—SO₂—BzOH′) abbreviated as Slm 1643.

FIG. 233A illustrates a reaction of Slm 1643 with sulfonated polyamide (SPA) 1644 in the presence of N-methylpyrrolidone (NMP), triphenyl phosphate (TPP), pyridine (C₅H₅N), and calcium chloride (CaCl₂) at 100° C. for 8 h resulting in the copolymer polyamide sulfonimide (SPA-co-Slm) 1645 with ionic (N—H⁺) group 1646 as an ionomer. In an alternative ionomeric polymer shown in FIG. 233B, reactant 4,4′-dicarboxyldiphenyl sulfonimide monomer Slm 1643 is combined with sulfonated polyamide (sSPA) 1644s resulting in sulfonated copolymer sSPA-co-Sim 1645s including ionomer-A with ionic (N—H⁺) group 1646 and ionomer-B comprising sulfonic acid 1054. This new ionomeric polymer offers higher conductivity than its purely polyamide antecedent. It is also the first known reported polymer containing two different ionomer types—ionomer-A comprising a hydrogen ion based ionic (N—H⁺) group 1646, and ionomer-B comprising a sulfonic acid group (SO₃H) 1054. By integrating two different redundant ionomer types into one ion exchange membrane, the risk of degraded membrane conductivity from membrane poisoning is reduced.

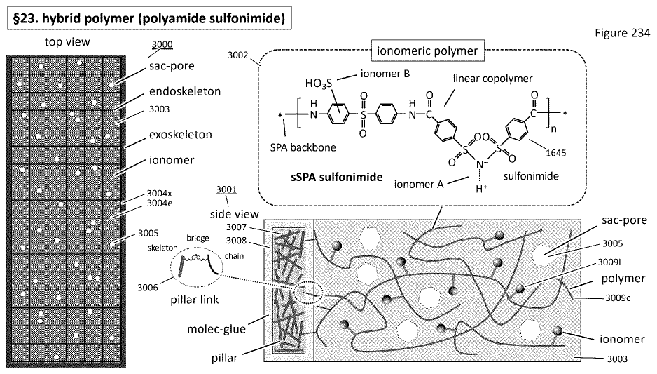

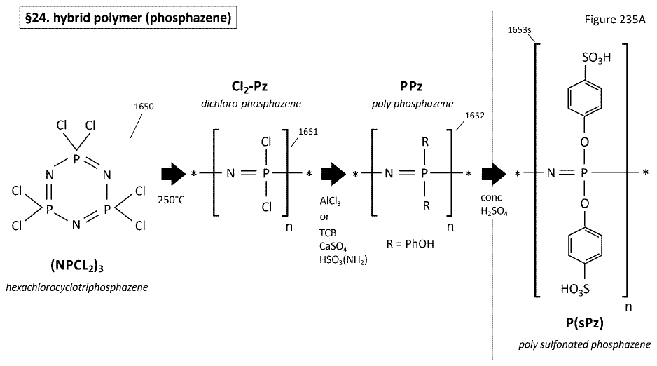

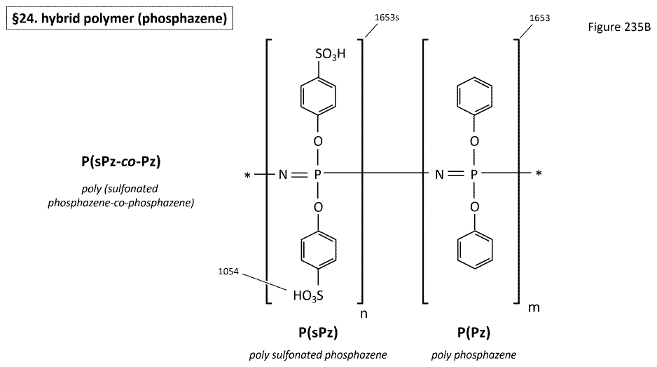

In summary, membrane top view 3000 and membrane side view 3001 in FIG. 234 illustrate a variety of elements of ionomeric polymer 3002 comprising a polyamide sulfonimide IEM made in accordance with this invention, including separately or in combination inventive matter comprising
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 is polyamide sulfonimide 1645 optionally blended with other homopolymers, heteropolymers, copolymers, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group N⁻H⁺, —SO₃H, SO₃Na, and sulfobutyl groups, and a second ionomer comprising sulfonic acid —SO₃H, integrating two different ionomers into a common IEM.
where ionomeric polymer 3002 may include ionic fillers (not shown);
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally,
where the combination of the endoskeletal pillars and the membrane coating are used to seal in any ionic liquid doping to prevent seepage, leakage, or IL depletion.

The following table describes the construction of polyamide-sulfonimide copolymer hybrid membranes. Linear copolymers of sulfonated and un-sulfonated polyamide (PAm) represent the principal instance of hybrid PAm copolymers. Endoskeletal pillar materials compatible with polyamide membranes include cyanoacrylate adhesives (CA) able to bond to fine features especially when fast curing is desirable; epoxy adhesives (EPX) bond to PAm, especially two-component epoxies offering improved durability; polyurethane (PU) form strong flexible bonds with PU using polyurethane adhesives or solvent welding.

| ionomer | structure | endoskeleton | solvents, X-L | fillers |
|---|---|---|---|---|
| §23. polyamide sulfonimide | hybrid PAm | polymers: CA, PU, | solv: HF, PFD, | sac filler, CNTs, |
| copolymers | copolymers | EPX | BTF, F-626 | oxides, POSS, |
| SPA-co-Slm | | pillars: reinforcing | X-L: CPL, SAm | NPs, MOFs, PIL |
| | | fillers (C-fiber, CNTs) | | |

Solvents used in forming polyamide-sulfonimide polymers include formic acid (FA), cresol (C₇H₈O), or fluoric solvents such as fluorane (HF), perfluorodecalin (PFD), benzotrifluoride (BTF), and perfluorooctyl-dimethylbutyl-ether (F-626). Catalysts and reagents beneficial in polymerizing polyamide-sulfonimide membranes and cross linking them to other polymers include E-caprolactam (CPL, (CH₂)₅CNH), sulfonamide (SAm). Membranes fillers and dopants were described previously and for brevity's sake, will not be repeated here.

### § 24. Functionalized Hybrid Phosphazene (Pz) Polymer IEMs.

Phosphazene comprises several classes of organophosphorus compounds comprising phosphorus (V) with a double-bond between phosphorus and nitrogen, i.e. N=P. Although phosphazene, also known as iminophosphoranes or phosphine imides may be used in filter membranes for water purification and gas separation, it can also be functionalized into an ionomeric membrane either for proton exchange membranes including direct methanol fuel cells or in anion exchange membranes. Material properties include resilience to chemical attack, thermal stability, and flexibility.

An exemplary process for formation of a phosphazene membrane is illustrated in FIG. 235A. In classical phosphazene synthesis, ring opening of hexachlorocyclotriphosphazene (NPCL₂)₃ 1650 performed by heating at 250° C. for several hours results in the phosphazene monomer dichloro-phosphazene (Cl₂-Pz) 1651. The phosphazene monomer can be polymerized into poly(phosphazene) (PPz) 1652 by heating at temperatures exceeding 250° C. Alternatively, the reaction can be catalyzed by Lewis acids such anhydrous aluminum chloride (AlCl₃) at 200° C. or by trichlorobenzene (TCB) with hydrated calcium sulfate (CaSO₄·2H₂O) as a promoter and sulfamic acid (HSO₃ (NH₂)) as a catalyst. During polymerization, the chloride groups of the Cl₂-Pz 1641 precursor are replaced by radical R, specifically where R comprises a phenyl group attached to oxygen, aka phenol ether or Ph-OH.

Subsequent oxidation in concentrated sulfuric acid (H₂SO₄) sulfonates the phenol groups thereby synthesizing poly sulfonated phosphazene P(sPz) 1653s. Not all phosphazene groups become sulfonated. Some radical remain as unfunctionalized phenol groups. A linear copolymer comprising a mix or sulfonated phosphazene P(sPz) 1653s and un-sulfonated phosphazene P(Pz) 1653 is illustrated in FIG. 235B as poly(sulfonated phosphazene-co-phosphazene), symbolically as P(sPz-co-Pz).

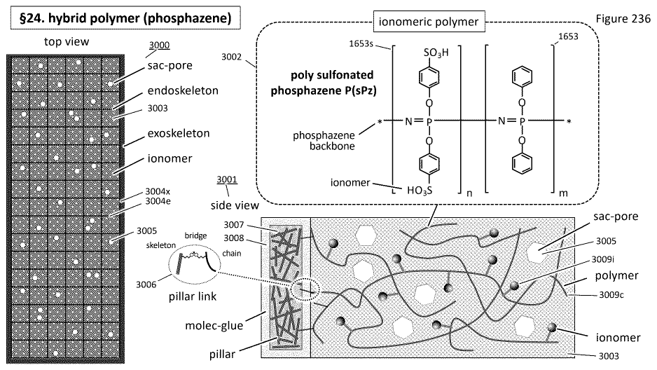

Membrane top view 3000 and membrane side view 3001 in FIG. 236 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 is sulfonated and un-sulfonated phosphazene 1653s and 1653 optionally blended with other homopolymers, heteropolymers, copolymers, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers (not shown)I;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

Linear copolymers of sulfonated and un-sulfonated phosphazene (Pz) represent the principal instance of hybrid PAm copolymers. Endoskeletal pillar materials compatible with phosphazene (Pz) membranes include: compatible phosphazene blends (Pz) formed to achieve specific chemical and structural properties present in the Pz membrane; polyurethanes (PU) using polyurethane adhesives offering versatile adhesion capabilities; silicone polymer (SiP) bonded to Pz using silicone-base polymer adhesives; and epoxy resins (EPX) offering strong adhesive properties bonding with a variety of materials including Pz. The table below describes the construction of phosphazene copolymer hybrid membranes:

| ionomer | structure | endoskeleton | solvents, X-L | fillers |
|---|---|---|---|---|
| §24. phosphazene | hybrid Pz | polymers: Pz, PU, SiP, EPX | solv: C₆H₁₄, tol, | sac filler, CNTs, |
| heteropolymer | polymers | pillars: reinforcing fillers | THF | oxides, POSS, |
| P(sPz-Pz) | | (C-fiber, CNTs) | X-L: AlCl₃, TCB, | NPs, MOFs, PIL |
| | | | CaSO₄, HSO₃(NH₂) | |

Solvents of phosphazene (Pz) include tetrahydrofuran (THF, oxolane), hexane (C₆H₁₄), and toluene (tol, PhCH₃). Catalysts and reagents beneficial in polymerizing phosphazene (Pz) membranes and cross linking them to other polymers include Lewis acids such anhydrous aluminum chloride (AlCl₃) or trichlorobenzene (TCB), hydrous calcium sulfate (CaSO₄·2H₂O), and sulfamic acid (HSO₃ (NH₂)). Membranes fillers and dopants were described previously and for brevity's sake, will not be repeated here. Membranes fillers and dopants were described previously and for brevity's sake, will not be repeated here.

### § 25. Hybrid Siloxane (SiX) Polymer IEMs.

Siloxanes are polymers comprising a backbone of silicon and oxygen [•••-Si—O—Si—O—Si-•••] forming strong bonds resilient to attack. These silicon sites also bond to organic radical side groups R₁, R₂, and R₃ producing a polymer [•••-R₂Si—O—SiR₂—O—SiR₃-•••]. Each silica functional group [RₓSiO—], referred to siloxy, may be identical or may differ from one another.

These radicals, often comprising methyl, ethyl or phenyl groups define many of the polymer's material properties such as crystallinity, porosity, rigidity, durability, and temperature coefficient. Siloxane also known as silicone should not be confused with the element silicon which it contains—silicon is an element, silicone is a polymer. As, such siloxane can be used in forming membranes for a variety of application including high selectivity separation of gasses and liquids, for proton and anion ion exchange membranes in fuel cells, for separators in lithium ion batteries, for hydrolysis, for electrodialysis, for antibacterial filtering, and more.

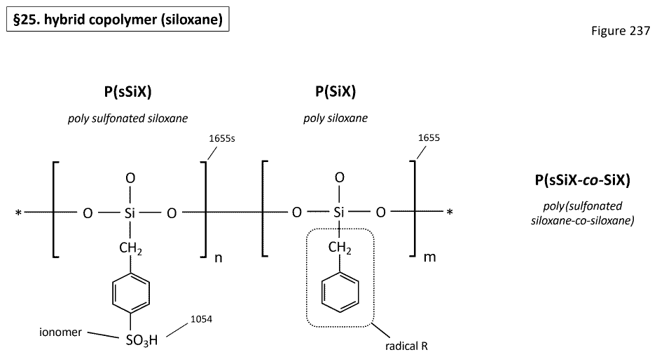

While pristine siloxane containing few ionized groups exhibits poor electrical conductance, any or all of these side groups can then be functionalized by catalytic or ionomeric termini. An exemplary heteropolymer for siloxane membrane is illustrated in FIG. 237 comprising un-functionalized poly siloxane P(SiX) 1655 and sulfonated poly siloxane P(SiX) 1655s including sulphonic acid ionomer 1054. Alternatively, phosphonium ionomers can be grafted onto siloxane polymers.

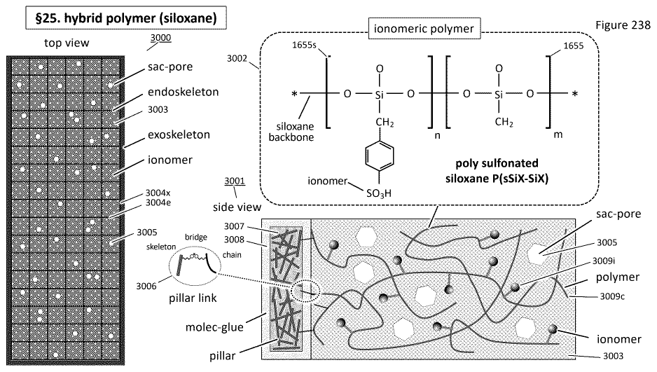

In summary, membrane top view 3000 and membrane side view 3001 in FIG. 238 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 is a heteropolymer of sulfonated siloxane 1655s and unfunctionalized siloxane 1655 optionally blended with other homopolymers, heteropolymers, copolymers, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers (not shown)I;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR₄⁺; phenolic hydroxyl groups —OH, or any other acidic group which easily ionizes to donate conducting cations of H⁺, Na⁺, or K⁺ into the solid electrolyte; and finally
Endoskeletal pillar materials compatible with phosphazene (Pz) membranes include: compatible phosphazene blends (Pz) formed to achieve specific chemical and structural properties present in the Pz membrane; polyurethanes (PU) using polyurethane adhesives offering versatile adhesion capabilities; silicone polymer (SiP) bonded to Pz using silicone-base polymer adhesives; and epoxy resins (EPX) offering strong adhesive properties bonding with a variety of materials including Pz;
where the combination of the endoskeletal pillars and the membrane coating are used to seal in any ionic liquid doping to prevent seepage, leakage, or IL depletion.

The table below describes the construction of siloxane heteropolymer hybrid membranes:

| ionomer | structure | endoskeleton | solvents, X-L | fillers |
|---|---|---|---|---|
| §25. siloxane | hybrid SiX | polymers: SiA, PU, | solv: C₇H₁₆, tol, | sac filler, CNTs, |
| heteropolymers | polymers | EPX, CA | Bz, TCM | oxides, POSS, |
| P(sSiX-co-SiX) | | pillars: reinforcing | X-L: C₂Bz, Me₂ | NPs, MOFs, PIL |
| | | fillers (C-fiber, CNTs) | | |

Endoskeletal pillars bonding with siloxane membranes include silicone-based adhesives (SiA) and polyurethanes (PU) both well matched to bonding silicone membranes; and for epoxy resins (EPX) and cyanoacrylate adhesives (CA) as a general purpose adhesives. Solvents for siloxane (SiX) copolymers include heptane (C₇H₁₆), toluene (tol), benzene (Bz), and chloroform (trichloromethane, TCM). Catalysts and reagents beneficial in polymerizing siloxane (SiX) hybrid membranes include dichlorobenzoyl catalysts such as 2,4-dichlorobenzoyl peroxide (C₁₄HCl₄O₄), and dimethyl compounds such as 2,5-dimethyl (C₃₂H₆₆O₂). Membranes fillers and dopants were described previously and for brevity's sake, will not be repeated here.

### § 26. Functionalized Hybrid Triazine (Tz) Polymer IEMs.

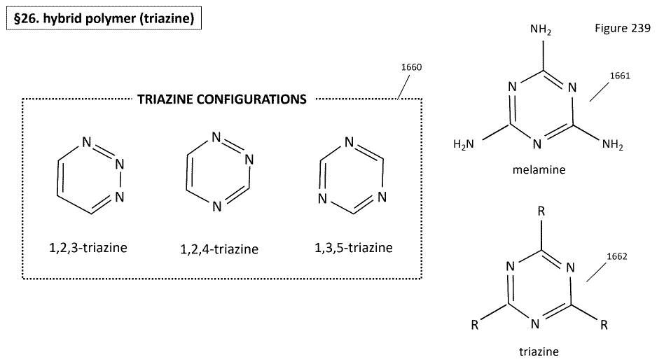

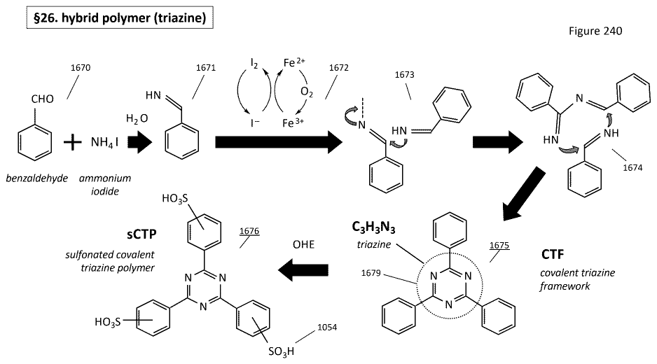

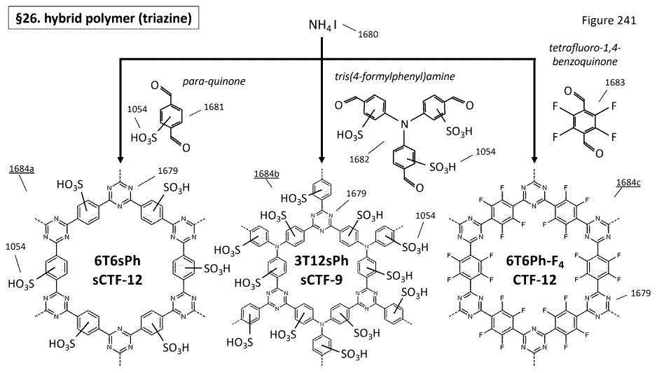

Triazine is a class of nitrogen-containing heterocycles based on the general molecular formula is C₃H₃N₃. Comprising a six-sided benzene-like ring with three nitrogen for carbon substitutions, triazine molecules are named by the location of the nitrogen substitutions on the aromatic ring, e.g. 1,2,4-triazine substitutes nitrogen on the first, second, and fourth positions. For the purpose of this invention, there is no distinction among these variation topological moieties as they only secondarily influence ionomeric membrane performance by influencing crystallinity. FIG. 239 comparatively illustrates an overview of triazine monomers from reference Wikipedia showing three molecular configurations 1660 and two exemplary common moieties melamine 1661 and triazine 1662 not specifically related to IEMs.

FIG. 240 illustrates an exemplary process for formation of a perfluorinated covalent triazine framework reacting benzaldehyde 1670 with ammonium iodide (NH₄I) and H₂O to form intermediary 1671. By ionization of I₂ into I⁻ and oxidation of Fe²⁺ to Fe³⁺ forming triazene template 1673, addition reaction connects additional phenyl groups sequentially 1674 centered around a locus forming a covalent triazine framework (CTF) 1675 with three phenyl groups and a triazine (C₃H₃N₃) core 1679. The CTF becomes the building block for vastly more complex and expansive triazine structures. For example, treatment in a sulfonic acid like OHE functionalizes CTF 1675 into sulfonated covalent triazine polymer 1676 with sulfonic acid ionomer 1054. Alternatively for use in direct methanol fuel cells, covalent triazine frameworks can be functionalized by phosphoric acid (H₃PO₄). Synthesis of triazine frameworks include low-temperature synthesis and subsequent steps for sulfonating triazine's aromatic rings. Pd nanoparticles can be included to form a bifunctional catalyst for one pot hydrogenation esterification reactions.

FIG. 241 illustrates how ammonium iodide (NH₄I) 1680 can be polymerized into various triazine configurations of covalent triazine frameworks (CTFs). For example, sulfonated 1,4-benzoquinone 1681 commonly known as para-quinone (C₆H₄O₂) forms a circular-shaped CTF 1684a of twelve aromatic rings in the CTF, half of which are comprise triazine groups, the other half forming sulfonated phenyl groups. Unique to this application we define a the first ever nomenclature for covalent triazine frameworks where accordingly CTF 1684a is be called 6T6sPh sCTF-12.

The term sCTF-12 is a top level descriptor describing covalent triazine frameworks (CTF) 1684a comprises 12 aromatic rings (−12) lining its interior surface and is sulfonated at least in part, hence the prefix of a small letter s. This name does not describe how many phenyls or triazine radiate outside the inner ring of the CTF. The nominative 6T6sPh provides a greater structural detail when 6T refers to six triazine rings 1679 while the term 6sPh means the CTF also includes six sulfonated phenyl rings. The two description can be used separately or preferably together to describe the superstructure of a covalent triazine framework. Mixing ammonium iodide (NH₄I) 1680 with three benzene compound 1682 results in a different CTF framework 1684b. While this CTF has a more tile-like geometry than the first example. As shown it contains only nine aromatic rings on its inner periphery, hence its name sCTF-9. That said the CTF unit cell comprises a total of three triazines 1679 and twelve sulfonated phenyl groups. As such, its superstructure is 3T12sPh. In other words the CTF unit cell is composed of 15 rings, only nine of which reside on its inner periphery. If ammonium iodide (NH₄I) 1680 is mixed with tetrafluoro-1,4-benzoquinone 1683 the resulting triazine framework CTF-12 is also circular shaped with twelve aromatic rings, none of them sulfonated hence its name CTF-12. The term 6T6Ph-F₄ identifies the framework includes six triazines 1619, and six phenyls each with four fluorine atoms.

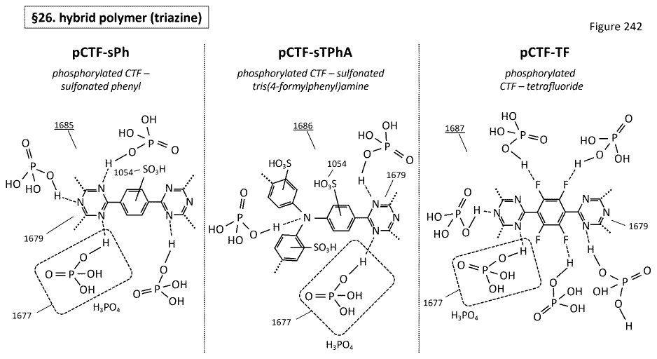

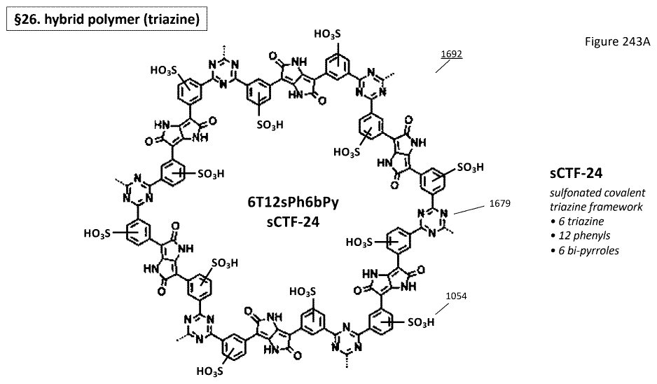

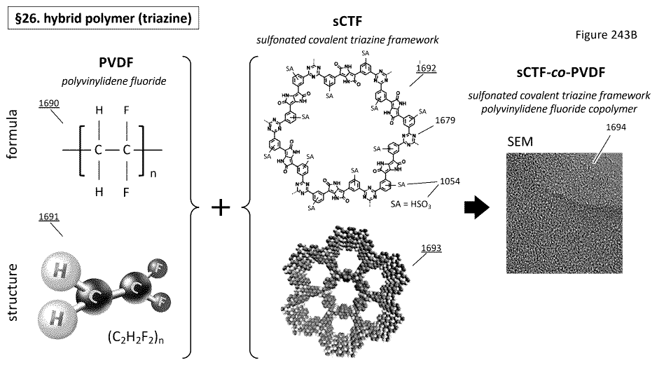

Although covalent triazine frameworks may manifest tile-like or ring-like geometries, some structures are topologically more linear or random. FIG. 242 illustrates several examples of phosphorylated covalent triazine frameworks, i.e. pCTFs. In each instance shown, a phosphoric acid group (H₃PO₄) 1677 has been attached to one or more triazine groups as a source of protons for conduction. Other phosphoric acid groups may also attach to available nitrogen or fluorine atoms. A phosphoric doped covalent triazine framework is therefore designated by its acronym pCTF.

For example in phosphorylated CTF—tetrafluoride (pCTF-TF) 1687, two triazines 1679 bind a center tetrafluoride phenyl group. Phosphoric acid groups 1677 bond to nitrogen atoms of the triazine but also bond to fluorine atoms on the tetrafluoride group. No fluorine is present in this example, meaning ionomeric conduction is regulated by the phosphoric groups and not be sulfonic acid as in most ionomers.

By contrast, phosphorylated CTF—sulfonated phenyl (pCTF-sPh) 1685 made in accordance with this invention combines both phosphoric acid 1677 and sulfonic acid 1054 into a common covalent triazine framework representing a new class of ionomer, described herein as a co-ionomer able to conduct through two different ionomeric moieties in the same group. Advantages of the newly invented co-ionomer is its ability to conduct over a wider range of ambient conditions such as hydration, pH, and temperature and to provide redundancy protecting against ionomer poisoning by H₂O₂ and other parasitic compounds. As shown pCTF-sPh 1685 includes phosphoric acid 1677 bonded to nitrogen atoms of triazine 1679 and sulfonic acid 1054 bonded to the phenyl group Ph held between the two triazine groups. As such, the moniker pCTF-sPh describes a phosphorylated covalent triazine framework with a sulfonated phenyl group.

Another example of phosphoric-sulfonic co-ionomer CTF is the molecule shown in the center illustration comprising phosphorylated CTF—sulfonated tris(4-formylphenyl)amine aka pCTF-sTPA 1686. As its name indicates, the triazine framework comprises one phosphorylated triazine group 1679 with attached phosphoric acid 1677 molecules (pCTF) combines with sulfonated tris(4-formylphenyl)amine comprising a central nitrogen axle and three phenyl groups, each with attached sulfonic acid (SO₃H) 1054 groups, hence its name sTPA as the acronym sulfonated tris-phenylamine. As shown, the central nitrogen may also bond to an additional phosphoric acid group.

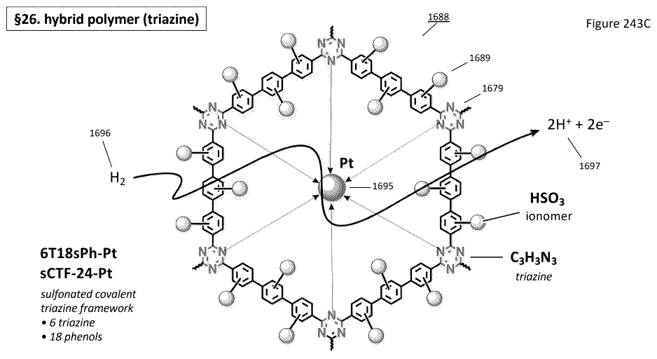

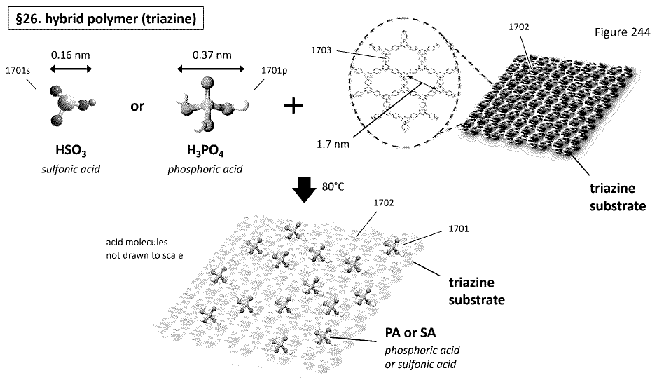

FIG. 243A illustrates a sulfonated covalent triazine framework sCTF-24 1692 comprising (a) 6 triazine groups, (b) 12 phenyl groups, and (c) 6 reflected bi-pyrrole groups. In accordance with this invention the molecule can be identified as 6T12sPh6bPy meaning six triazine (CT), twelve sulfonated phenyls (12sPh), and six reflected bi-pyrrole groups (6bPy) forming the sCTF-24 covalent triazine framework with a 24 element inner periphery. Although the original application of this triazine network is for filtration, in accordance with this invention the phenyl groups have been functionalized by sulfonic acid (SO₃H) 1054 to convert the un-sulfonated CTF into an ionomer sCTF.

FIG. 243B illustrates an exemplary process for formation of a blended PVDF-triazine polymer forming a porous functionalized covalent-triazine frameworks for enhanced adsorption toward polysulfides in Li-S batteries and organic dyes. The described CTF copolymer is intended as a separator for lithium ion batteries and is therefore not ionomeric or designed to conduct protons. As such, it is not useful in ionomeric or catalytic membranes needed in fuel cells, electrolysis systems, or in electrodialysis, but is insightful in designing triazine fabrication sequences.

Made in accordance with this invention, the CTF has been sulfonated into sCTF 1692 by the addition of sulfonic acid (SA, SO₃H) 1054 onto the phenyl groups in the CTF superstructure as combined with triazine 1679. This step can be performed by modifying phenyl groups using an aromatic substitution reaction, wherein a hydrogen atom on an arene is replaced by a sulfonic acid group (—SO₂OH) in an electrophilic aromatic substitution reaction with fuming sulfuric acid (H₂SO₄) where

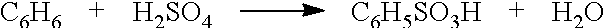

As indicated sulfur trioxide (SO₃) or its protonated derivative is the electrophile substituted for hydrogen in the reaction. Since water is a byproduct of the reaction, dehydrating agents can accelerate reaction rates by reducing acid dilution during the reaction. For example, adding thyionl chloride (SOCl₂) to the above reaction eliminates the production of excess water by instead forming (SO₂+2HCl). An alternative to sulfuric acid is to sulphonate the aromatic ring using chlorosulfuric acid (HSO₃Cl) in which case the substitution react becomes

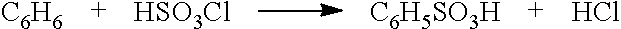

Other methods to sulphonate benzene or phenyl rings include the Tyrer sulfonation process developed in 1917 and the Piria reaction of 1851. Regardless of the method used to sulphonate the phenyl groups of the triazine framework, he resulting molecular structure 1693, once modified is suitable for use in membranes. Rather than attempting to form a whole new class of membranes and overcome all the challenges therein, an alternative is blend the sulfonated CTF as a filler and dopant into an existing membrane fabrication process. One such candidate is polyvinylidene fluoride (PVDF). As shown polyvinylidene fluoride (PVDF) 1690 with a molecular structure (C₂H₂F₂)ₙ 1691 when combined with the newly reported sulfonated covalent triazine framework sCTF 1682 can produce a sulfonated version of a copolymer of PVDF and CTF, i.e. sulfonated covalent triazine framework polyvinylidene fluoride copolymer (sCTF-co-PVDF). Since the ionomeric regions added to the CTF having the same morphology as the un-sulfonated copolymer pictured in SEM 1694.

Because covalent triazine frameworks were developed for antibacterial filters and for water purification, they are not ionomeric nor catalytic nor do they represent the same field of science or inventive art as ion exchange membranes. As described above, using methods made in accordance with this invention to functionalize covalent triazine frameworks (CTFs) into sulfonated covalent triazine frameworks (sCTFs), phosphorylated covalent triazine frameworks (pCTFs), or the combination of both into co-ionomeric sulfonated phosphorylated covalent triazine frameworks (spCTF).

FIG. 243C illustrates a sulfonated version of a 6T18sPh covalent triazine framework (sCTF-24-Pt) 1688 comprising 6 triazine (C₃H₃N₃) 1679 groups and 16 phenyl groups functionalized by sulfonic acid (HSO₃) ionomer 1689. Uniquely, the sCTF-24 shown includes a platinum (Pt) ion 1695 at its center. Alternatively, this metallic core could have been palladium (Pd) or any other catalyst. As shown hydrogen gas 1696 passing through the triazine pore unavoidably encountering the catalyst 1695 splitting the fuel into protonic hydrogen ions (H⁺) and electrons 1697. Given the close proximity between the catalyst and ionomer the charge transfer efficiency is enhanced as cations formed by the catalyst are instantly handed off to the ionomers 1689 for charge hopping conduction. This efficient charge transfer mechanism between catalyst and ionomer means that this inventive hybrid catalyst-ionomer covalent triazine framework (sCTF-24-Pt) 1688, offering improved conductance, particularly if the sCTF is coated atop an ion exchange membrane as an interfacial layer between the membrane and catalyst.

Alternatively a scavenger metal such as nickel, iron, cobalt, etc. could be inserted in place of catalyst metal 1695, the purpose of which is to bond to or impede the transport of carbon monoxide through the membrane especially to protect the anode catalyst from carbon monoxide poisoning. As a protective layer, sCTF-24-Pt 1688 should be coated on the cathode side of the membrane to disrupt CO diffusion before it can even enter the IEM. The protective function of scavenger metals is described in greater detail in section § 34 on MOFs.

Although aforementioned processes involve co-synthesis of covalent triazine frameworks functionalized by sulfonic or phosphoric acid, an alternative process of doping a triazine substrate after it is fabricated is shown in FIG. 244. As depicted triazine substrate 1702 comprises a hexagonal tile with pores 1703 having dimensions of 1.7 nm. Comparing the pore size with the molecular dimensions of the substituted acids 1700 reveals that sulfonic acid with dimension 1701s of 0.16 nm is smaller than that of phosphoric acid 1701p having dimensions 0.37 nm, more than double that of sulfonic acid. As such, made in accordance with this invention, functionalizing a triazine membrane with sulfonic acid 1701s producing a higher acid load in substrate 1702 and therefore offers a greater enhancement in conductivity than its phosphoric counterpart.

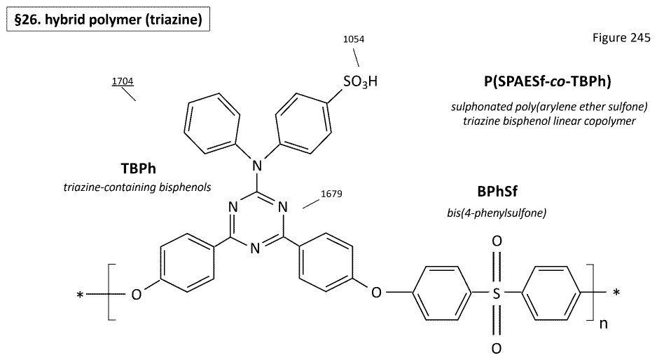

Another fabrication method for forming an ionomeric membrane with triazine does not involve covalent triazine networks but instead comprises triazine containing bisphenols (TBPh) formed by bonding sulfonated bisphenols to triazine 1679. As shown in FIG. 245, the triazine containing bisphenol (TBPh) compound forms a copolymer with bis(4-phenylsulfone) (BPhSf), together forming a sulphonated poly(arylene ether sulfone) triazine bisphenol linear copolymer P(SPAESf-co-TBPh) 1704.

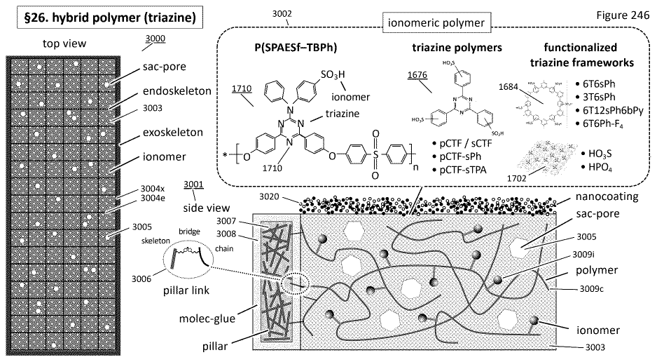

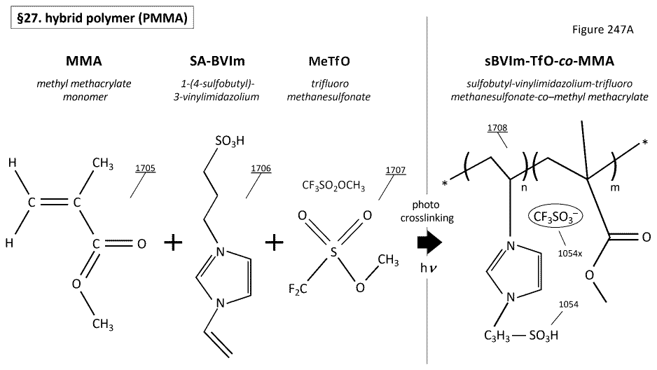

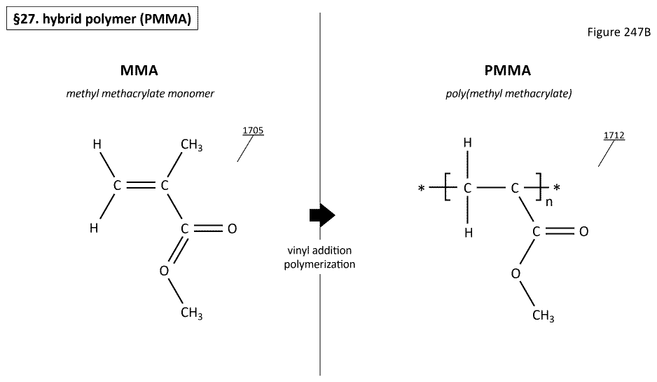

In summary, membrane top view 3000 and membrane side view 3001 in FIG. 246 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber, CNTs or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating 300 is formed atop membrane 3003 or at the interface between the cathode catalyst and the membrane to either enhance membrane conductivity, increase the rate of oxygen reduction reactions (ORR) in the cathode, or provide protection against membrane poisoning, and where the nanocoating may comprise a covalent triazine framework containing ionomers and/or catalysts such as Pt or Pd, and/or scavenger metals such as Ni, Co, or Fe, and/or may include boron nitride or other materials that inhibit the diffusion of carbon monoxide (CO) into the catalyst layer;
where ionomeric polymer 3002 is sulfonated triazine 1710, phosphorylated triazine 1702, or uniquely both sulfonated and phosphorylated triazine, optionally blended with other homopolymers, heteropolymers, and copolymers, such as SPAESf or PVDF thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers (not shown)I;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte and finally;
where the combination of the endoskeletal pillars and the membrane coating are used to seal in any ionic liquid doping to prevent seepage, leakage, or IL depletion.

The table below describes the construction of triazine (Tz) polymer and copolymer hybrid membranes:

| ionomer | structure | endoskeleton | solvents, X-L | fillers |
|---|---|---|---|---|
| §26. triazine copolymers | hybrid Tz | triazine polymers: | solv: DMSO, EtOH, | triazine fillers/coat: |
| and heteropolymers | polymers & | EPX, Ph, PI, CE | MeCN, MeOH, | 6T6sPh, 3T12sPh, |
| PCTF/sCTF | copolymers | copolymers: pillar | H₂O, TCM | 6T6Ph-F₄, pCTF-sPh, |
| PCTF-sPh | | matched to IEM | X-L: SA, HCl, KOH, | PCTF-TF, sCTF-24, |
| PCTF-sTPA | | polymer; | NaOH, AlCl₃, ZnCl₂, | PCTF-sTPhA, |
| PCTF-TF | | pillars: reinforcing | heat, UV light | 6T18sPh-Pt |
| 6TsPh, 3T6sPh | | fillers (C-fiber, CNTs) | | membrane fillers: |
| 6T6Ph-F₄ | | | | sac filler, CNTs, |
| 6T12sPh6BPy | | | | oxides, POSS, NPs, |
| sCTF-co-PVDF | | | | MOFs, PIL |
| P(SPAES)-co-TBPh | | | | |

Ionomers include sulfonated and phosphorylated covalent triazine frameworks (CTF) where a lowercase ‘p’ prefix indicates phosphorylated CTFs, a lowercase ‘s’ prefix indicates a sulfonated CTF, phenyl, or phenol group, and a upper case P denotes a polymer. Endoskeletal pillars able to bond to triazine membranes include epoxy resins (EPX) creating a cross-linked network between the epoxy matrix and the triazine framework; phenolic resins (Ph) linking the CTF via phenol ligands; polyimides (PI) which easily bond to triazine as PI often triazine rings in their structure to provide high thermal stability and enhance its mechanical strength; and cyanate esters (CE) which easily polymerize through and into triazine rings, forming a highly cross-linked thermoset polymer with excellent thermal stability and dielectric properties.

Solvents used in forming triazine (Tz) polymers include dimethyl sulfoxide (DMSO) comprising a highly polar organic solvent that can dissolve many organic and inorganic compounds including some triazines; acetonitrile (MeCN) a polar aprotic solvent able to dissolve a wide range of compounds including triazines; methanol (MeOH) and ethanol (EtOH), polar solvents that can dissolve many polar substances including some triazines; water (H₂O) able to dissolve water soluble triazines especially those with hydrophilic groups; and chloroform (trichloromethane, TCM), another slightly polar solvent.

Catalysts and reagents beneficial in polymerizing siloxane-triazine (Tz-Sx) hybrid membranes and cross linking them to other polymers include strong acids such as sulfuric acid (H₂SO₄, SA) or hydrochloric acid (HCl); strong bases such as sodium hydroxide (NaOH) or potassium hydroxide (KOH); Lewis acids comprising metal salts such as aluminum chloride (AlC₃) or zinc chloride (ZnCl₂); heat and ultraviolet light. Triazine nanoparticles can also be used as fillers or coatings including the previously described molecules and frameworks 6T6sPh, 3T12sPh, 6T6Ph-F4, pCTF-sPh, pCTF-TF, sCTF-24, pCTF-sTPhA, and 6T18sPh-Pt. Other membranes fillers and dopants were described previously and for brevity's sake, will not be repeated here.

### § 27. Functionalized Poly Methyl Methacrylate (PMMA) Hybrid Polymer IEMs.

Methyl methacrylate (MMA) with the chemical composition CH₂═C(CH₃)COOCH₃. is a methyl ester of methacrylic acid (MAA). MMA is the monomer of poly methyl methacrylate (PMMA) used primarily in the production of acrylic plastics, one of the oldest plastic in use. It is also used as a economical alternative to alternative to polycarbonate (PC) when flexural and tensile strength, transparency, and UV tolerance are more important than impact strength, chemical resistance, and heat resistance. Compared to polystyrene and polyethylene, PMMA is more stable to environmental insults. Non electrochemical applications of PMMA include lenses for vehicular lighting and eye glasses, signs and displays, window coatings, and as a shatter proof substitute for glass. It is also used extensively for medical and dental fillers and implants including the hollow fiber kidney.

Applications of PMMA membranes have been primarily for kidney dialysis. Because of its small pore size, PMMA is also used for air separation. Conversely, the small pore size of pristine PMMA makes a poor candidate for ion exchange membranes limiting gas and ionic transport thereby diminishing conductance. Attempts to form ionomeric membranes with PMMA rely on copolymerization to enhance film porosity. For example FIG. 247A illustrates steps for forming a MMA copolymer starting with the methyl methacrylate (MMA) monomer 1705 combined with a sulfonated co-monomer 1-(4-sulfobutyl)-3-vinylimidazolium (SA-BVIm) 1706 and with trifluoro-methanesulfonate (MeTfO) 1707.

Using photochemical cross-linking to promote the reaction the copolymer sulfobutyl-vinylimidazolium trifluoro methanesulfonate-co-methyl methacrylate (sBVlm-TfO-co-MMA) 1708. The impinging light source comprises photons with energy E=hν where ν=h/c is the frequency of the light used in photoexcitation, h is Planck's constant, and c is the speed of light.

This process comprises photoactivation od protic ionic liquid [HSO₃—BVIm][TfO] with MMA and hPFSVE to form aromatic rings with sulfonic acid (SO₃H) mediated via cyclopropene radicals (C₃H₃). Photo processing is however not scalable to production volumes and suffers from poor uniformity and incomplete polymerization.

An alternative approach shown in FIG. 247B is to employ vinyl addition polymerization to convert methyl methacrylate (MMA) monomer 1705 to poly methyl methacrylate (PMMA) 1712. The methyl group (CH₃) formed by this process is however not ionomeric and not easily functionalized. In accordance with this invention, sulfonation of CH₃ requires a complex sequence involving (i) halogenation, (ii) sulfonic synthesis, (iii) substitution, and (iv) hydrolysis. During halogenation one hydrogen atom in the methyl group is replaced with a halogen such as chlorine or bromine using reagents like chlorine (Cl₂) or bromine (Br₂) in the presence of a catalyst like iron (Fe) or iron (III) chloride (FeCl₃). The result is a benzyl halide, e.g., benzyl chloride if chlorine is used.

The next step involves introducing the SO₃H group onto the halogenated group. This may be achieved through a sulfonation reaction using fuming sulfuric acid (H₂SO₄) or chlorosulfonic acid (SO₃Cl). During substitution, halogen on benzyl halide can then undergo a nucleophilic aromatic substitution if it is an activated aryl halide, or a nucleophilic aliphatic substitution if it is a primary halide. Should the sulfonation step results in a sulfonyl chloride (R—SO₂Cl) instead of a sulfonic acid (SO₃H), a hydrolysis step may be required to convert the sulfonyl chloride into the corresponding sulfonic acid by treatment by water or an aqueous base.

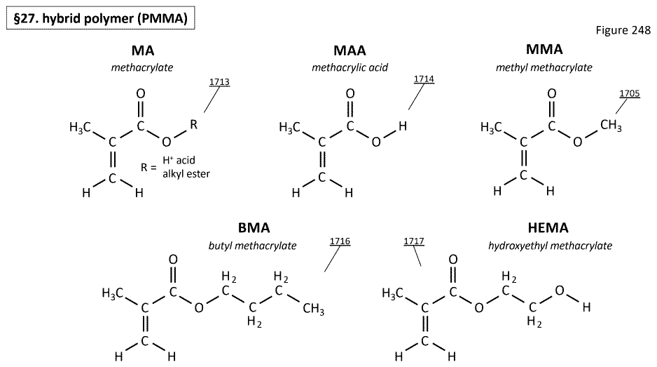

In the absence of this complex functionalization, the synthesized PMMA 1712 polymer is neither ionomeric or catalytic. Aside than MMA monomer 1705, other monomers shown in FIG. 248 include methacrylate (MA) 1713, methacrylic acid (MAA) 1714, butyl methacrylate (BMA) 1716, and hydroxyethyl methacrylate (HEMA) 1717. These monomers too do not produce ionomeric or catalytic polymers.

PMMA can also be used to form nanospheres rather than membranes. PMMA nanospheres, properly functionalized and used as permanent fillers in polymers, offer numerous advantage over PMMA membranes. Most notably nanospheres exhibit significantly more surface area and ionomers densities than a two-dimensional membrane comprising sheets of ionomers. This surface area advantage confers greater ionomer density than that available limited to the porous channels and more conduits meandering through a polymeric membrane. These nanoparticles can be used as dopants or fillers in a range of polymers, either to enhance conductivity, control porosity, or catalytically promote faster reaction rates.

Unfortunately published processes for forming PMMA nanospheres focus on synthesizing nano-coatings for improving light emitting diode efficiency, totally unrelated to forming ionomers for ion exchange membranes. For example, forming PMMA using emulsion polymerization has been researched by the Univ of Wisconsin Madison and published online by its MRSEC group. Focused wholly on polymethylmethacrylate (PMMA) nanospheres for photonics, the fabricated nanospheres enhance optical quantum efficiency but are not intended to enhance fuel cell efficiency.

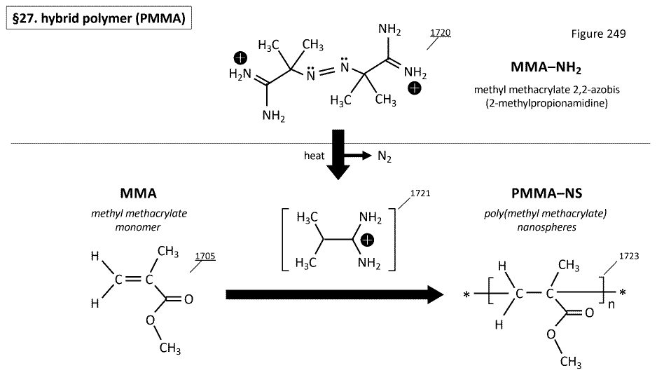

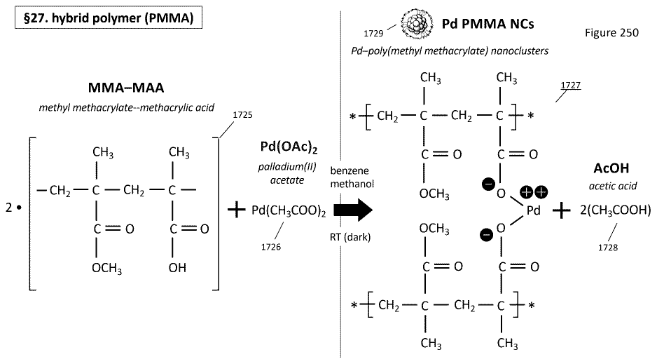

The work does however illustrate methods to form PMMA nanospheres. As shown in FIG. 249, the process involves treating a methyl methacrylate monomer 1705 with thermal derivative 1721 of methyl methacrylate 2,2-azobis (2-methyl-propionamidine) (MMA-NH₂) 1720. The chemical product, poly(methyl methacrylate) nanosphere PMMA-NS 1723 itself comprises a linear polymer with methane side groups, some of which populate the surface of the nanosphere. In other words the nanosphere is self forming. The nanospheres are not however ionomeric or catalytic. In other words additional technology is required to functionalize PMMA nanospheres fabricated in this manner. Like triazine described previously, PMMA nanospheres can be formed to host catalytic elements such as palladium. One exemplary process for forming catalytic PMMA forming poly(methyl methacrylate)-supported Pd⁰ obtained from room-temperature, dark reduction of ionic aggregates of the unstable Pd²⁺ solution ionomer. In this process, methyl methacrylate—methacrylic acid (MMA-MAA) is blended with palladium(II) acetate (Pd(OAc)₂, Pd(CH₃COO)₂) 1726 along with solvents methanol and benzene at room temperature in the dark to form Pd-poly(methyl methacrylate) nanospheres 1727 and byproduct acetic acid (AcOH, CH₃COOH) 1728 as shown in FIG. 250. The nanospheres 1727 then group into nanoclusters 1729.

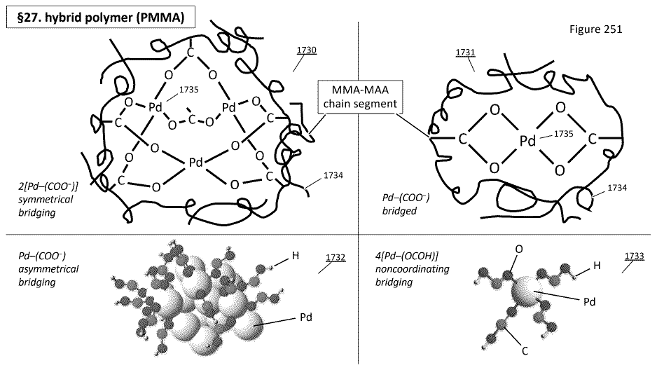

Depending on bridging within the cluster different configurations and reactivities may result as shown in FIG. 251. For example MMA-MAA chain 1734 with covalently bonded symmetrically (COO−) bridged palladium 1735 forms nanocluster 1730. By contrast, palladium centric nanocluster 1731 surrounds only a single palladium atom 1735. Asymmetrical Pd—COO⁻ bridging produces palladium clusters 1732 while noncoordinating bridging 4[Pd—(OCOH)] results in an single Pd anthropomorphic configuration 1733.

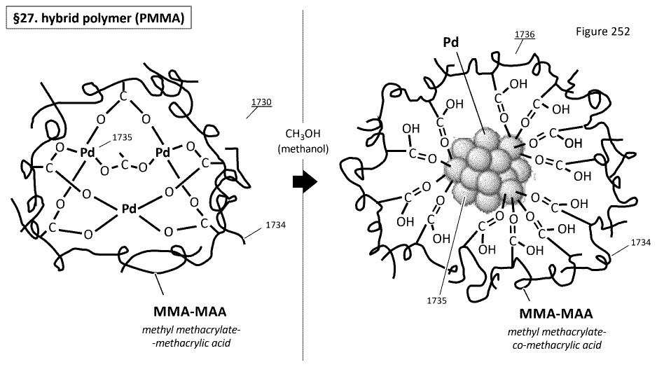

FIG. 252 illustrates how methanol (CH₃OH, MeOH)I is able to convert methyl methacrylate-methacrylic acid (MMA-MAA) 1734 into nanocluster 1736 containing numerous palladium atoms 1735 forming a central locus within the circumscribing MMA-MAA chain 1734. Such PMMA structures, while catalytic are not ionomeric.

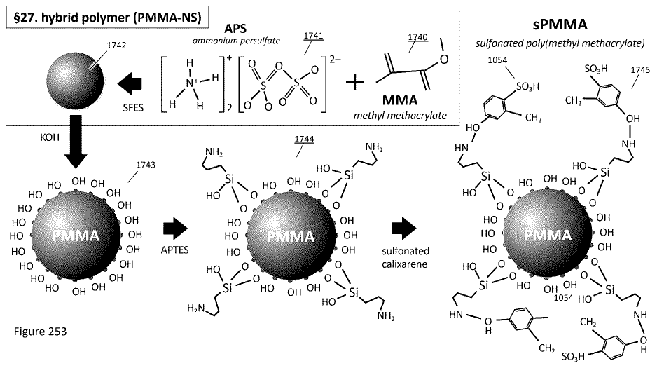

Once a stable nanosphere or nanocluster is formed, functionalization with sulfonic or phosphoric acid is more straightforward. For example, as shown in FIG. 253, the combination of ammonium persulfate (APS) 1741 and copolymer methyl methacrylate (MMA) 1740 produces PMMA unfunctionalized nanosphere 1742. Treatment in KOH swells the polymer while attaching hydroxide (OH) to exposed bonds to produce a reactive PMMA-NS 1743. Subsequent treatment in (3-aminopropyl)triethoxysilane (APTES) attaches silicon to certain surface hydroxide (OH) groups, where each silicon includes dangling NH₂ termini results in amino PMMA 1744. Finally treatment in sulfonated calixarene, i.e. cyclic methylene-linked phenols, results in sulfonated poly(methyl methacrylate (sPMMA) 1745. Conventional applications of PMMA nanospheres include filtration such as removal of vanadium Ions from aqueous media.

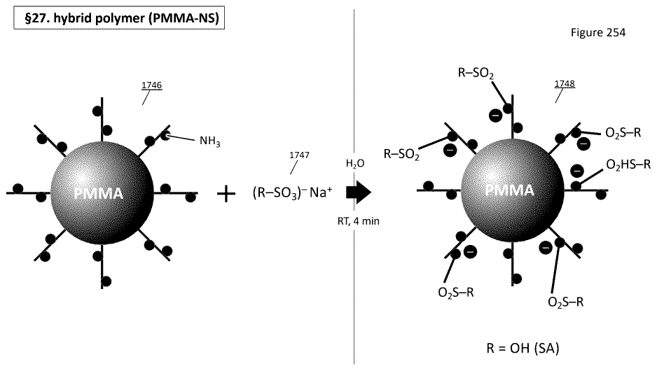

FIG. 254 illustrates PMMA decorated by NH₃ 1746 can be functionalized by radical 1747 comprising (R—SO₃)⁻Na⁺ in water to form PMMA 1748 with numerous O₂HS—R functional groups. The radical R can then be functionalized by hydroxide (OH) to produce SO₃H ionomers. Other processes for sulfonating a PMMA nanosphere include conjugates:

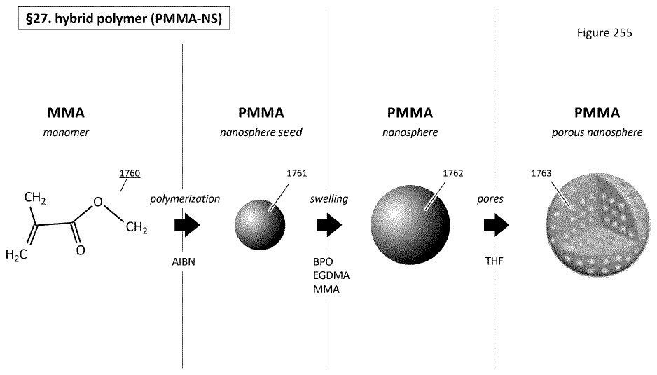

FIG. 255 illustrates a process to create porous or collapsed PMMA nanospheres starting with MMA monomer 1760 polymerized by azobisisobutyronitrile (AlBN) to form PMMA nanosphere seed 1761. The PMMA seed is then swelled by soaking in benzoyl peroxide (BPO), ethylene glycol dimethacrylate (EGDMA), and by more MMA to create adult PMMA nanosphere 1762. Subsequent immersion in tetrahydrofuran (THF) etches pores in nanosphere 1763. A process for controlling the porosity of PMMA depends on the application of different porogen treatment on porous PMMA microspheres by seed swelling polymerization. Applications of these PMMA microspheres include their use in high-performance liquid chromatography.

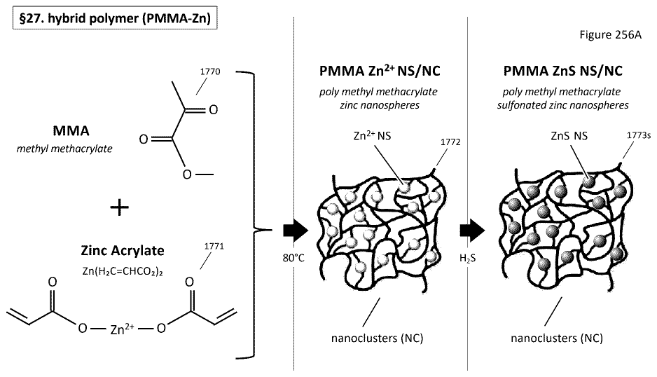

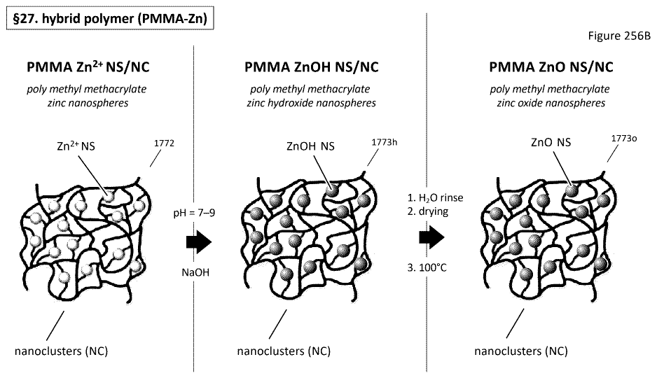

The direct formation of nanoclusters, i.e. aggregates of nanospheres illustrated in FIG. 256A where methyl methacrylate (MMA) 1770 is combined with zinc acrylate (Zn(H₂C═CHCO₂)₂) to form poly methyl methacrylate zinc (PMMA Zn NCs) nanoclusters 1772 with zinc in the Zn²⁺ divalent state. The final step, functionalization in hydrogen sulfide (H₂S) gas produces a nanocluster 1773 of ZnS nanospheres bound by a PMMA matrix. The resulting structure is referred to as PMMA ZnS NCs. A related process for forming zinc PMAA is comprises multifunctional ionomer-derived honeycomb-patterned architectures used to enhance the performance of light-emitting diodes.

Made in accordance with this invention, the Zn²¹ zinc PMMA nanosphere 1772 can be functionalized in a two-step process comprising treatment in sodium hydroxide (NaOH) producing poly methyl methacrylate zinc hydroxide nanospheres (PMMA ZnOH NS) 1773h. Subsequently a H₂O rinse followed by drying and heat treatment 100° C. converts zinc hydroxide (ZnOH) into zinc oxide (ZnO). The resulting nanocluster comprises an aggregate of poly methyl methacrylate zinc oxide nanospheres 1773o.

The zinc nanoparticles can may be added as an ionic filler into membranes comprising PFSA or PVA as inorganic ion exchange sites within the matrix improving conductivity and film stability. Unlike organic compounds, inorganic ion exchange sites cannot be detected using detected using absorbance spectroscopy so their presence and electrical activity is determined indirectly by measuring the electrical behavior of IEMs with and without the ZnO nanoparticle or PMMA-ZnO doping. They may be used in hydrogen PEM furl cells and direct methanol fuel cells (DMFCs).

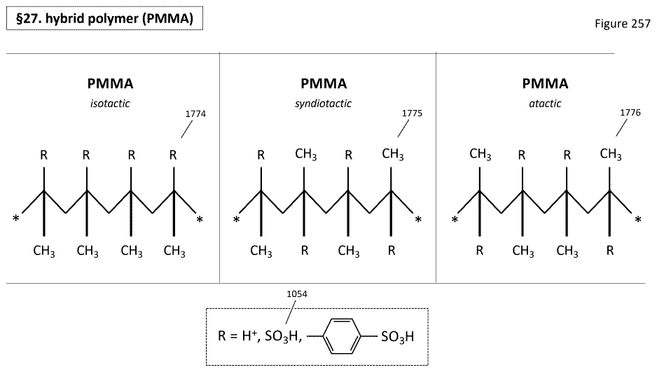

PMMA polymers may form in various isometric arrangements of radical R groups. An isomer is a group of chemical having the same chemical formula and compositions but with different structural arrangements. Examples of PMMA isomers shown in FIG. 257 include the isotactic isomer 1774 where radicals appear topologically on the same side of the molecule, in the syndiotactic isomer 1775 where methane (CH₃) groups and radicals R alternate, or in an atactic configuration 1776 where the radicals repeat in pairs. Various polymerizations of MMA isomeric moieties include efforts in transparent and stretchable active matrices functionalized by radicals R. In the structures shown, radicals R are neither catalytic nor ionomeric and are therefore not useful in ion exchange membranes for hydrolysis or fuel cells.

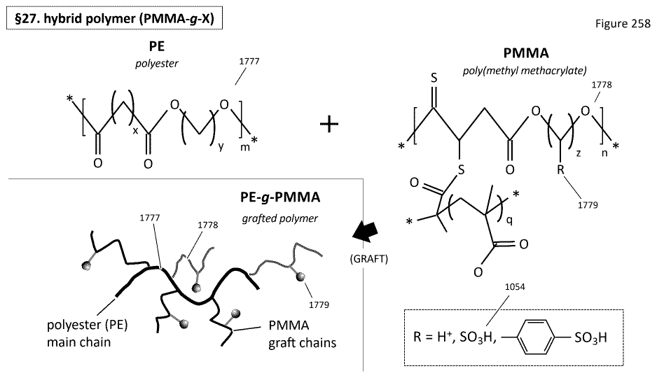

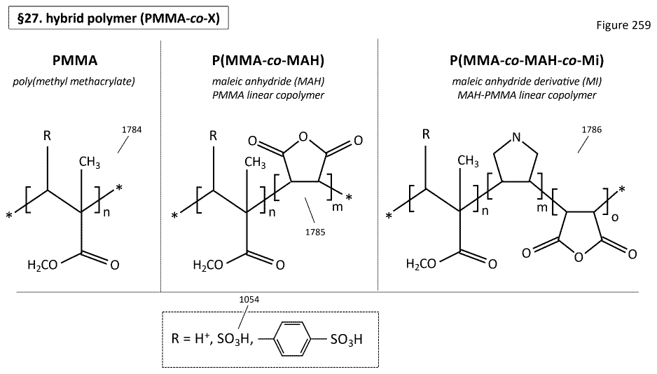

Made in accordance with this invention, poly methyl methacrylate (PMMA) polymers shown previously in FIG. 257 can be functionalized by various ionomeric radicals including hydrogen ions H⁺, sulfonic acid (SO₃H), or sulphonated phenyl groups regardless of whether the PMMA is in the form of a membrane, film, nanosphere, or nanocluster. Methods in substitution chemistry able to convert a non-ionomeric radical into an proton exchange group by attaching ionized hydrogen (H⁺) groups, sulfonic acid (SO₃H), sulfonated phenyl group (C₆H₆—SO₃), or other acids (not shown) such as boric acid (H₃BO₃), phosphoric acid (H₃PO₄), citric acid (CA), and benzenesulfonic acid (BzSA, BzSO₃H, C₆H₆O₃S), and others have been described previously and will not be repeated here. Poly(methyl methacrylate) may also form copolymers with or be grafted onto various other polymeric chains. In FIG. 258 for example PMMA 1778 is grafted onto polyester 1777 to form the grafted polymer PE-g-PMMA with ionomeric radicals 1779. Other PMMA moieties functionalized by an ionomeric radical R shown in FIG. 259 include pristine poly(methyl methacrylate) (PMMA) 1784; maleic anhydride (MAH) PMMA linear copolymer P(MMA-co-MAH) 1785; and the maleic anhydride derivative (MI) of MAH-PMMA linear copolymer P(MMA-co-MAH-co-Mi) 1786. Although such molecules are not intrinsically catalytic or ionomeric, made in accordance with invention all radical R groups may be substituted by a hydrogen acid group H⁺, by sulfonic acid (SO₃H), by phenylated sulfonic acid (C₆H₆—SO₃), by boric acid (H₃BO₃), phosphoric acid (H₃PO₄), citric acid (CA), and benzenesulfonic acid (BzSA, BzSO₃H, C₆H₆O₃S), and others.

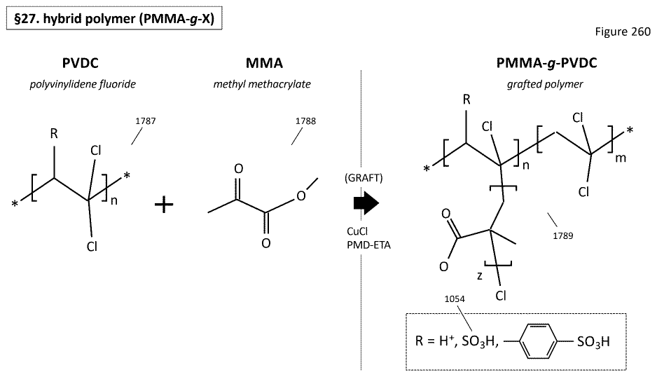

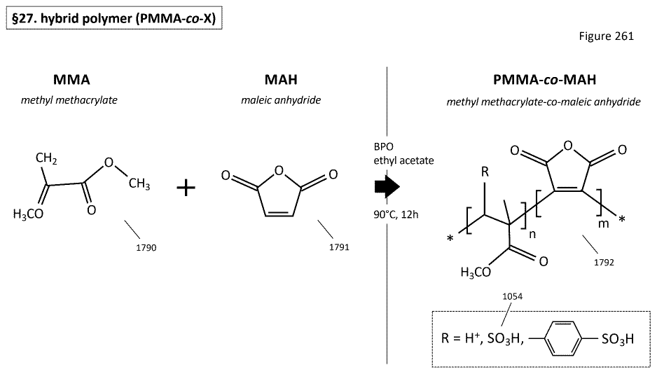

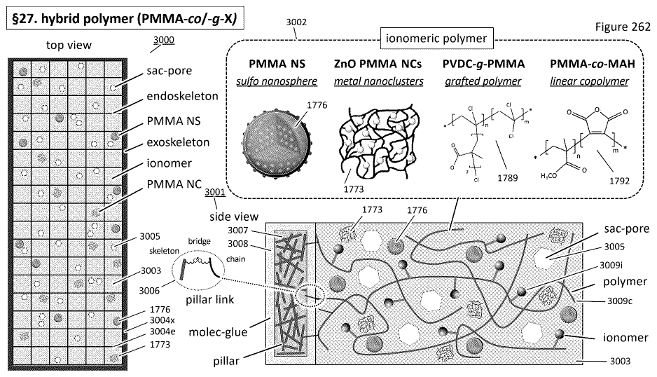

Another grafted polymer PMMA-g-PVDC 1789 is depicted in FIG. 260 where methyl methacrylate (MMA) 1788 is polymerized into a chain and grafted onto polyvinylidene fluoride (PVFC) 1787. FIG. 261 illustrates copolymerization of maleic anhydride (MAH) 1791 with methyl methacrylate (MMA) 1790 in benzoyl peroxide (BPO, (BzO)₂) and ethyl acetate (EtOAc, ETAC, C₄H₈O₂) to produce the linear copolymer PMMA-co-MAH 1792. Without added steps, the process does not however produce ionomeric or catalytic PMMA, unless made in accordance with this invention the radical R groups are substituted by an ionomeric acid group such as phosphonic acid.

In summary, top view 3000 and membrane side view 3001 in FIG. 262 illustrate a variety of elements of ionomeric polymer 3002 comprising PMMA membranes, polymers, copolymers, and grafted polymers made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 is a copolymers and graft of poly(methyl methacrylate) including pure PMMA 1778; grafted polymers PE-g-PMMA 1779 and PVDC-g-PMMA 1789; and linear copolymers PMMA-co-MAH 1791, poly(MMA-co-MAH-co-Mi) 1786, and poly(MMA-co-MAH) 1785; and optionally blended with other homopolymers, heteropolymers, copolymers, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers including PMMA nanosphere 1776 and PMMA nanoclusters 1773 including ZnS and ZnO;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

Hybrid poly(methyl methacrylate) structures include both PMMA membranes and PMMA fillers comprising copolymers and grafts. PMMA copolymer membranes include the tetra copolymer sulfobutyl-vinylimidazolium-trifluoro-methanesulfonate-co-methyl methacrylate (sBVlm-TfO-co-MMA).

Radical R functionalized PMMA membranes include grafts of poly(methyl methacrylate) with polyester (PMMA-g-PE) or with polyvinylidene fluoride (PMMA-g-PVDF), and copolymers with maleic anhydride P(MMA-co-MAH) and with maleic anhydride derivatives P(MMA-co-MAH-co-Mi). The radical* R may comprise hydrogen ions (H⁺), sulfonic acid (SO₃H, SA), phenylated sulfonic acid (Ph-SA, C₆H₆—SO₃), phosphoric acid (PA, H₃PO₄), boric acid (BA, H₃BO₃), citric acid (CA, C₆H₈O₇), and benzenesulfonic acid (BzSA, BzSO₃H, C₆H₆O₃S), and others.

The table below describes the construction of methyl methacrylate (MMA) and poly methyl methacrylate (PMMA) copolymers and grafted hybrid membranes:

| ionomer | structure | endoskeleton | solvents, X-L | fillers |
|---|---|---|---|---|
| §27. methyl methacrylate | hybrid PMMA | polymers: ABS, | solv: Ac, tol, DCE, | PMMA fillers: Pd |
| copolymers and grafts | copolymers | SAN, ASA, EMA, | MEK, DCM, NEth, | PMMA NC, Pd |
| sBVIm-TfO-co-MMA | | MBS, MABS, | Anon, TCM, PhCl, | P(MMA-PAA) NC, |
| functionalized* PMMA | | MMA-VA | Xylol, Anisole, | sPMMA, PMMA- |
| PE-g-PMMA | | pillars: | DEP, PMA, EtOAc, | SA, porous NS, |
| PMMA-g-PVDC | | reinforcing fillers | HCOOH | PMMA NCs (ZnS, |
| P(MMA-co-MAH) | | (C-fiber, CNTs) | X-L: BPO, CTA, | ZnO) |
| P(MMA-co-MAH-co-Mi) | | | tBPPiv | other fillers: |
| * R = H⁺, SA, Ph-SA, PA, | | | | sac filler, CNTs, |
| BA, CA | | | | oxides, POSS, |
| | | | | NPs, MOFs, PIL |

Endoskeletal polymers able to form pillar links with PMMA membranes include acrylonitrile butadiene styrene (ABS) used for its toughness and impact resistance; styrene-acrylonitrile (SAN) a copolymer of styrene and MMA able to bond to PMMA because of shared constitutes; acrylonitrile-styrene-acrylate (ASA) a copolymer of acrylonitrile, styrene, and acrylate also derived from MMA; ethylene methyl acrylate (EMA) copolymerized from ethylene and MMA; methyl methacrylate-butadiene-styrene (MBS) combining MMA with butadiene and styrene; methyl methacrylate-acrylonitrile-butadiene-styrene (MABS) and tetra copolymer of MMA with acrylonitrile, butadiene, and styrene; and methyl methacrylate-vinyl acetate (MMA-VA) a copolymer of MMA with vinyl acetate offering superior adhesion and flexibility.

Solvents used in forming methyl methacrylate (MMA) polymers include acetone (Ac, C₃H₆O) toluene (tol, PhCH₃, C₆H₅CH); dichloroethane (DCE, C₂H₂Cl₂); butanone aka methyl ethyl ketone (MEK); cyclohexanone (Anon, C₆H₁₀O); nitroethane (NEth, C₂H₅NO₂), chloroform (TCM, trichloromethane, CHCl₃); dichloromethane (DCM, CHCl₂) (or methylene chloride); benzene (Bz, C₆H₆); chlorobenzene (PhCl, C₆H₅Cl); xylene (Xylol, dimethylbenzene, C₈H₁₀); methoxybenzene aka anisole or phenyl methyl ether (CH₃OC₆H₅); diethyl phthalate (DEP); methoxypropyl acetate (PMA, C₆H₁₂O₃); ethyl acetate (EtOAc, C₄H₈O₂); ethyl lactate (Acytol, lactic acid, C₅H₁₀O₃); and formic acid (methanoic acid, HCOOH). Catalysts and reagents beneficial in polymerizing methyl methacrylate (MMA) hybrid membranes and cross linking them to other polymers include benzoyl peroxide (BPO, (BzO)₂), tert-butyl peroxypivalate (tBPPiv), thiol-containing chain transfer agents (CTAs).

PMMA based fillers as described include the palladium doped catalytic nanoclusters Pd PMMA and Pd P(MMA-PAA), sulfonated nanospheres sPMMA and PMMA-SA, zinc doped nanoclusters ZnS, ZnOH, and ZnO PMMA, and inert porous nanospheres. Other membrane fillers and dopants were described previously and for brevity's sake, will not be repeated here.

### § 28. Functionalized Hybrid Carboxy Methyl Cellulose (CMC) Polymer IEMs.

Given the propensity for ionomer fouling and fuel cross-over in direct methanol fuel cells (DFMCs) one alternative membrane to PFSA comprises a tri-copolymer of carboxy methyl cellulose (CMC) with polyvinyl alcohol (PVA). Carboxy methyl cellulose is a polysaccharide comprising a flexible water soluble polymeric matrix containing hydroxyl and sodium carboxymethyl groups (—CH₂COONa) derived from fibrous plant tissue. CMC beneficial material properties include biodegradability, nontoxicity, high hydrophilicity, biocompatibility and excellent film forming ability. A variety of CMC applications include its use in textiles, drugs, detergents, purification and flocculation, food processing, and more.

As a cellulose molecule, CMC suffers from limited stability and poor miscibility. By blending it with polyvinyl alcohol (PVA), CMC forms a copolymer offering increase its physicochemical properties such as miscibility, tensile strength, and higher ionic conductivity than CMC alone. Unfortunately the CMC-co-PVA copolymer is still electrically uncompetitive to other ionomeric membranes. To improve membrane conductivity, the copolymer can be mixed with acrylamide making it better suited for electrochemical applications.

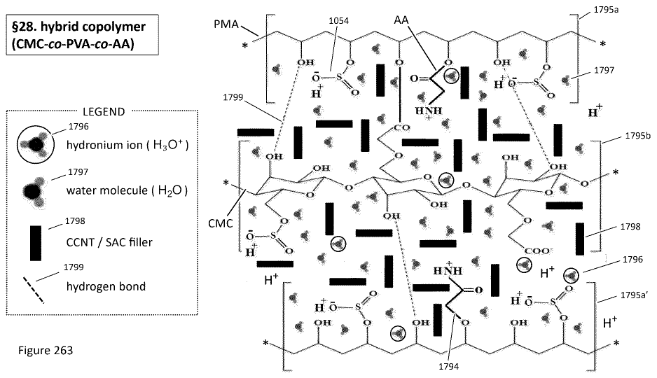

FIG. 263 illustrates a matrix comprising CMC mainchain 1795b with PMA backbones 1295a and 1295a′, and pendants of AA polymers 1794. The polymer backbones are bond together by hydrogen bonds 1799 resulting in a carboxy-methyl-cellulose-PVA-acrylamide copolymer (CMC-co-PVA-co-AA). The graphic also provides mechanistic depiction of putative proton conduction mechanisms in the sulfonated poly (vinyl alcohol)/carboxy methyl cellulose/acrylamide-based hybrid polyelectrolyte membrane. As shown, transport of H⁺ ions may occur through charge hopping among sulfonic acid ionomers 1054 or by vehicular transport of hydronium ions (H₃O) 1796 combining water 1797 with H⁺ ions.

Film conductance may be further enhanced by ionomeric fillers 1798 comprising sulfonated activated carbon (SAC) or carboxylated carbon nanotubes (CCNT) or by doping with ionic liquids, all three of which may diffuse out of the membrane. In one embodiment of the invention the permanent fillers are constrained within the polymer matrix laterally by the endoskeletal pillar matric and perpendicular to the film by a nanocoatings. Alternatively CMC can be copolymerized with propylene carbonate (PC) and ammonium chloride. Proton conduction in CMC-co-PC is facilitated through dissociation of H⁺ from ammonium chloride (NH₄Cl) or alternatively from ammonium bromide (NH₄Br).

The table below describes the construction of carboxy methyl cellulose (CMC) copolymer hybrid membranes:

| ionomer | structure | endoskeleton | solvents, X-L | fillers |
|---|---|---|---|---|
| §28. carboxy methyl | hybrid CMC | polymers: PAM, PVA, | solv: water, IPA, IBA, | CMC fillers: |
| cellulose copolymers | copolymers | PEO, PEG, PAA, PVP | EtOH | SAC, CCNT |
| CMC-co-PVA | | pillars: reinforcing | X-L: HCOOH, AcOH, | other fillers: |
| CMC-co-PVA-co-AA | | fillers (C-fiber, CNTs) | H₂CO₃, pyr, glycolic, | sac filler, CNTs, |
| CMC-co-PC•NH₄Cl | | | acid, butyric acid, | oxides, POSS, |
| CMC-co-PC•NH₄Br | | | Acytol | NPs, MOFs, PIL |

Hybrid carboxy methyl cellulose (CMC) membranes include copolymers of CMC with polyvinyl alcohol (PVA), acrylamide (AA), and polycarbonate (PC) doped with NH₄Cl or NH₄Br. Endoskeletal polymers bondable to CMC polymers include polyacrylamide (PAM) able to form composites; polyvinyl alcohol (PVA) present in the copolymer; polyethylene oxide (PEO); polyethylene glycol (PEG) through hydrogen bonding forming hydrogels; and polyvinylpyrrolidone (PVP). Solvents used in forming carboxy methyl cellulose (CMC) copolymers include water, isopropanol (IPA), isobutanol (IBA), and ethanol (EtOH).

Catalysts and reagents beneficial in carboxy methyl cellulose (CMC) hybrid membranes and cross linking them to other polymers include citric acid (C₆H₅(O₇)³⁻) and carboxylic acids, i.e. acids containing carboxyl (—COOH) functional group. Carboxylic acids include formic acid (methanoic acid, HCOOH), carbonic acid (hydroxymethanoic acid, H₂CO₃), acetic acid (AcOH), glycolic acid (C₂H₄O₃), ethyl lactate (Acytol, lactic acid, C₅H₁₀O₃), pyruvic acid (Pyr, C₃H₄O₃), butyric acid (C₃H₇COOH), and others. CMC specific filers include sulfonated activated carbon (SAC) or carboxylated carbon nanotubes (CCNT). Other membrane fillers and dopants were described previously and for brevity's sake, will not be repeated here.

### § 29. Functionalized Hybrid Multi-Acid Sidechain (MASC) Polymer IEMs.

Rather than modifying the backbone of a polymer, an alternative approach to improve IEM performance over that offered by PFSA or Nafion® is to modify the construction of the pendant attaching the ionomer terminus to its polymer mainchain. Potential benefits of substituting the fluorocarbon pendant of 3M, Nafion® or Aquivion® with an alternative sidechain containing fewer hydro-fluorine groups is to adjust the film morphology and crystallinity to control swelling, water update, and fuel crossover, especially in direct methanol fuel cells (DMFCs). Generally the modification comprises a substitution of one ore more

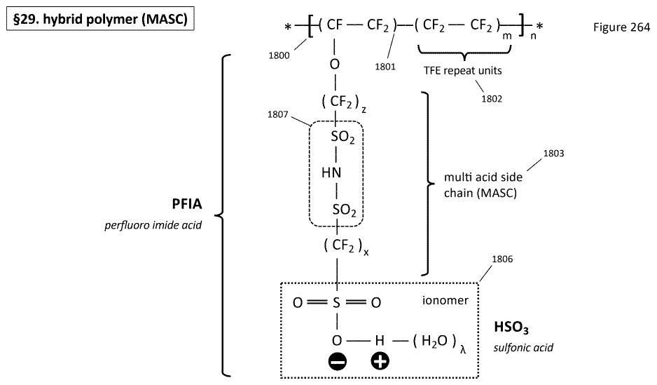

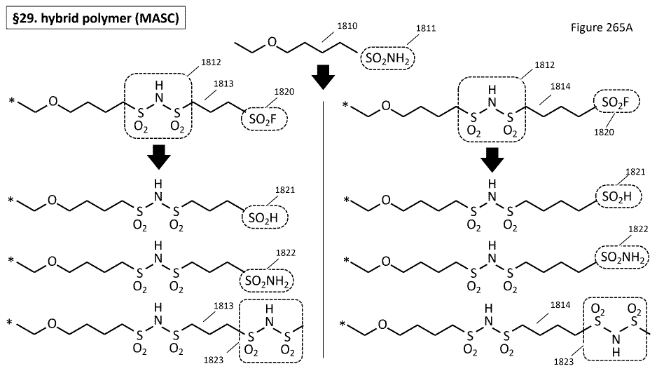

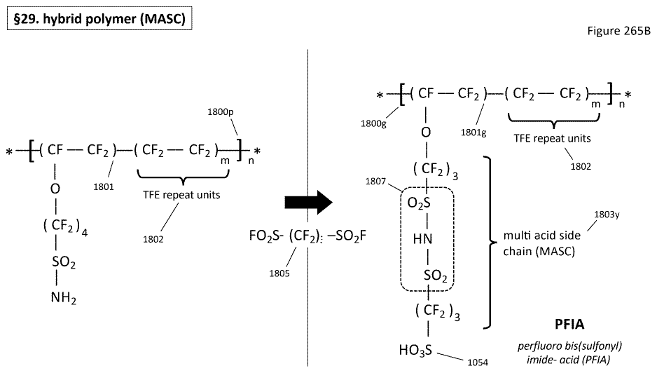

As shown in FIG. 264, a polymer backbone 1800 common to PFSA includes TFE repeated region 1802 and pendant link section 1801. The pendant comprises a z-repeated segment of (CF₂)_{z} and x-repeated segment of (CF₂)ₓ surrounding a central core of HN 1807 linearly enclosed by two SO₂ radicals. Together, the HN—SO₂ pendant substitute is referred to as a multi-acid sidechain (MASC) 1803. Combined with an ionomeric sulfonic acid group 1806, the MASC 1803 side group is referred to as perfluoro imide acid or PFIA.

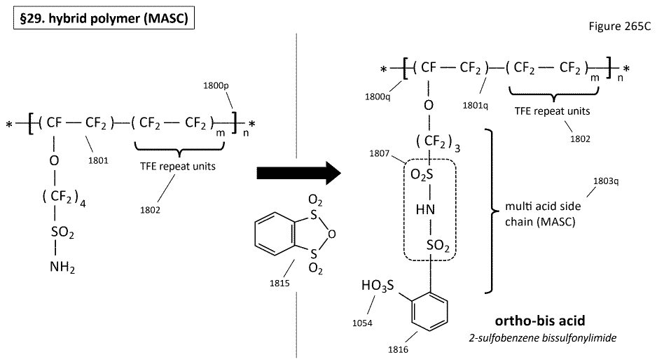

The technical report by the US Dept. of Energy consider that by adjusting the length of the MASC sidechain the film's properties prospectively may be varied. FIG. 265A illustrates a MASC can extended by successive repeated processes. For example, starting with imide acid precursor 1810, the first process step shown involves conversion of SO₂—NH₂ terminus 1811 into SO₂F 1820 during which time a sulfonyl fluoride group (SO₂—NH—SO₂) 1812 is inserted into the carbon sidechain. In the case of sidechain 1813 the sulfonyl fluoride is positioned three carbons from the SO₂F terminus while in sidechain 1814 the sulfonyl fluoride is positioned four carbons from the SO₂F terminus.

The relative position of the sulfonyl fluoride group within the sidechain remains unchanged in subsequent processing steps including (a) conversion of SO₂F terminus 1820 into SO₂H terminus 1821, (b) conversion of SO₂H terminus 1821 into SO₂—NH₂ terminus 1822, and (c) conversion of SO₂—NH₂ terminus 1822 into (SO₂—NH—SO₂) terminus 1823. Notice this structure is identical to that of sulfonyl fluoride group (SO₂—NH—SO₂) 1812 except that the group is positioned farther along a longer the sidechain. These longer MASC structures mat be referred to as perfluoro-ionone chain extended (PFICE) ionomeric polymers.

Direct synthesis of PFIA from PFSA is illustrated in FIG. 265B where PFSA precursor 1800p comprising PTFE segment 1802 and pendant section 1801 with NH₂ terminus are treated by reagent to form perfluoro bis(sulfonyl)imide-acid (PFIA) 1800g. As shown the PFIA 1800h comprises TFE segment 1802 and graft segment 1801g with multi acid sidechain (MASC) 1803y containing sulfonyl fluoride group (SO₂—NH—SO₂) 1807 and sulfonic acid (SO₃H) ionomer 1054.

Direct synthesis of a related MASC polymer is illustrated in FIG. 265C. Starting with the same PFSA precursor 1800p, treatment by phenyl reagent 1815 results in 2-sulfobenzene bissulfonylimide, aka ortho-biz acid 1800q including TFE segment 1802 and grafted segment 1801q where multi-acid sidechain (MASC) 1803q attaches to the polymer mainchain. As shown sidechain MASC 1803q includes the same sulfonyl fluoride group (SO₂—NH—SO₂) 1807 but with a different terminus comprising phenyl 1816 and sulfonic acid (SO₃H) ionomer 1054.

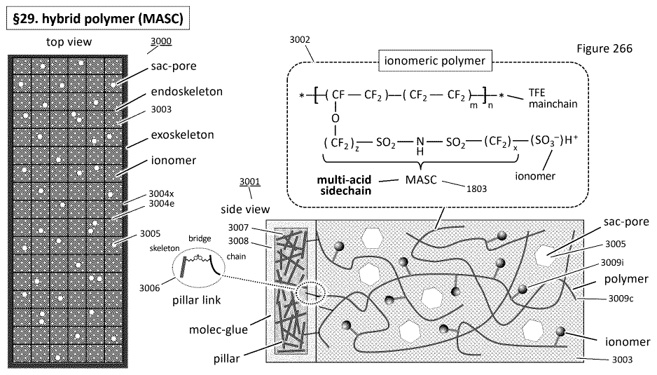

In summary, membrane top view 3000 and membrane side view 3001 in FIG. 266 illustrate a variety of elements of ionomeric polymer 3002 comprising multi acid sidechains made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 comprises a TFE mainchain optionally blended with other homopolymers, heteropolymers, copolymers, thereby controlling varying degrees of film crystallinity and anisotropy to form a hybrid copolymer;
where ionomeric polymer 3002 may comprise multi-acid sidechain 1803 serving as pendants and influencing crystalline regularity, porosity, conductivity, and fuel crossover of the membrane including perfluoro imide acid (PFIA), perfluoro-ionone chain extended (PFICE) polymers, or 2-sulfobenzene bissulfonylimide (ortho-bis acid);
where ionomeric polymer 3002 may comprise an ionomer 3009i of reactive sulfonic acid R group —SO₃H, SO₃Na, and sulfobutyl groups;
where ionomeric polymer 3002 may include embedded ionic fillers of electrospun nanofiber mats blending perfluoro imide acid and polyvinyl difluoride (PFIA-PVDF) or perfluoro imide acid and perfluorinated sulfonic acid (PFIA-PFSA);
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The table below describes the construction of multi acid sidechain (MASC) copolymer hybrid membranes based on a variety of ionomeric mainchains:

| ionomer | structure | endoskeleton | solvents, X-L | fillers |
|---|---|---|---|---|
| §29. multi-acid sidechain | MASC hybrid | polymer: | solv: catalysts, used | sac filler, CNTs, |
| modified polymers | polymer | matched to IEM | in forming polymers | oxides, POSS, |
| PFIA-PFSA MASC | | polymer. | match membrane, | NPs, MOFs, PIL |
| PFIA-PTFE MASC | | pillar: reinforcing | not filler | |
| ortho-bis acid MASC | | fillers (C-fiber, | X-L: reagents | |
| PFIA-co-PVA-co-PTFE | | CNTs) | matching | |
| PFIA-co-SPAES, sPEEK, | | | membrane | |
| sPEES | | | polymer | |
| PFIA-co-sPVA, sPBI, sCS | | | | |

Endoskeletal pillars should be chosen to bond to the mainchain polymer to which the PFIA or MASC attaches. Solvents used in forming multi-acid sidechains (MASC) modified copolymers are chosen to be compatible with the polymer mainchain. If for example the mainchain comprises a MASC modified PFSA homopolymer or a PFSA-PTFE, then solvents compatible with PFSA-PTFE are preferred. Similarly catalysts and reagents beneficial in multi-acid sidechains (MASC) hybrid membranes and cross linking them to other polymers are selected to match the polymer mainchain, not the pendant. Membranes fillers and dopants were described previously and for brevity's sake, will not be repeated here.

### § 30. Functionalized Hybrid Arylene Ether (PAE) Polymer IEMs.

Another class of thermoplastic polymers, poly(arylene ether)s (PAEs) have been developed for water filtration including oil/water separation, desalination, and wastewater treatment, which involve the removal of heavy metal ions, dyes, oils, and other organic pollutants. Beneficial characteristics of PAEs include corrosion resistance, high-temperature resistance, anti-fouling properties, and durability in challenging environments. Although limited, some effort has been made to adapt these compounds to form ionomeric membranes. While section § 13 considered functionalization of pristine poly arylene ether, synthesis of hybrid PAE blends confers beneficial morphological and electrical properties to proton exchange membrane (PEM) chemistry than pure PAE films cannot offer.

Ionomer membranes produced from hexaarylbenzene-based partially fluorinated poly(arylene ether) blends involve combining sulfonated poly(arylene)s and highly rigid hexaarylbenzene (HAB, HABz) derivatives with cardo structured fluorenyl, i.e. where the pendent groups comprise chains of aromatic rings such as phenyl, benzene, etc. In three dimensions, these pendent groups are necessarily orthogonal to the plane of the mainchain irrespective as to whether the polymer backbone also comprises aromatic rings. To promote rapid growth a high-boiling-point solvent such as dimethyl sulfoxide (DMSO) is also required.

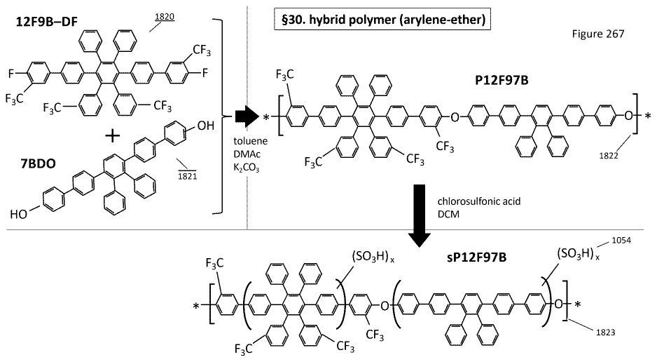

FIG. 267 illustrates a process for combining two different PAE polymers, (12F9B-DF) 1820 and (7BDO) 1821, with toluene, dimethylacetamide (DMAc), and potassium carbonate (K₂CO₃) to form hybrid heteropolymer (P12F97B) 1822. Polymerized difluoro monomer (4,4″″-difluoro-3,3″″-bis(trifluoromethyl)-2″,3″,5″,6″,4,4″″-difluoro-3,3″″-bis(trifluoromethyl) 2″,3″,5″,6″-tetra (trifluoro methyl) phenyl-[1,1′:4′,1″:4″,1″:4′″,1″″-quinquephenyl forms ionomer (12F9B-DF) 1820.

Ionomer (7BDO) 1821 comprises polymerized diphenol monomer 2″,3″-diphenyl-[1,1′:4′,1″:4″,1′″:4′″,1′″-quinquephenyl]-4,4″″-diol. The resulting polymer (P12F97B) 1822 is then functionalized by chlorosulfonic acid (CIHO₃S) and dichloromethane (DCM) to produce sulfonated PAE polymer s(P12F97B) 1823 including ionomer sulfonic acid (SO₃H) 1054.

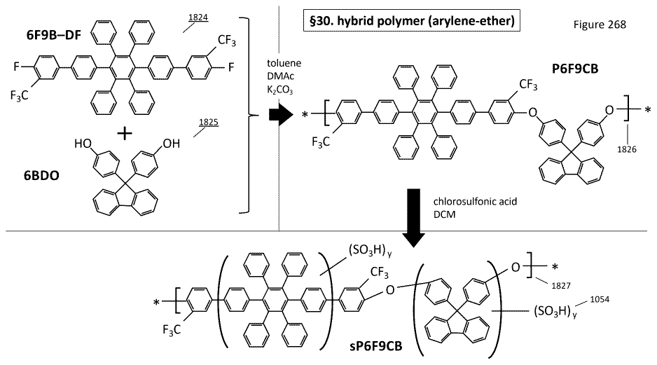

FIG. 268 illustrates a process for combining two different PAE polymers, (6F9B-DF) 1824 and (6BDO) 1825 with toluene, dimethylacetamide (DMAc), and potassium carbonate (K₂CO₃) to form hybrid heteropolymer (P6F9CB) 1826. Specifically PAE polymer (6F9B-DF) is synthesized from polymerization of a monomer comprising polymerization of 4,4″″-difluoro-3,3″″-bistrifluoromethyl-2″,3″,5″,6″-tetraphenyl-[1,1′;4′,1″;4″,1′″;4′″,1″″]-pentaphenyl. For the second reactant, CBDO 1825 is synthesized by the polymerization of diphenol monomer 4,4′-(9-fluorenylidene)diphenol. The resulting polymer (P6F9CB) 1826 is then functionalized by chlorosulfonic acid (CIHO₃S) and dichloromethane (DCM) to produce sulfonated PAE polymer s(P6F9CB) 1827 including ionomer sulfonic acid (SO₃H) 1054.

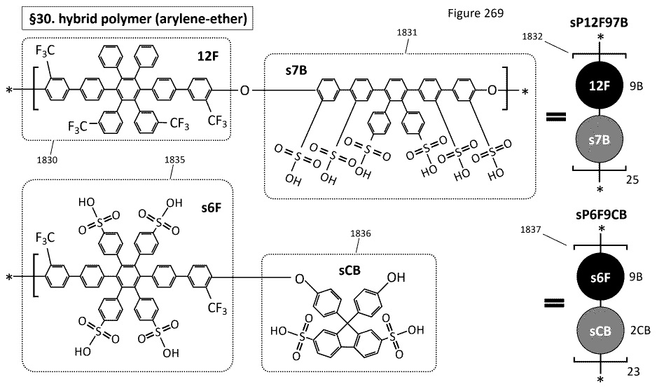

FIG. 269 illustrates one lexicological convention used in naming hybrid PAE polymers. As shown hydrophobic segments 1830 and 1835 containing —CF₃ groups are named 12F and 6F respectively by counting the number of fluorine atoms. Both moieties contain 9 benzene rings. Alternatively for the hydrophilic segments 1831 and 1836, the number of benzene rings of in the former is seven hence its naming 7B, and in the later is a cardo structured benzene named as CB although a more accurate term should be 2CB.

Using this somewhat confusing naming system, the sulfonated PAE polymer 1852 containing segments 12F and 7B is referred to as P12F9B7B which has been shortened to P12F97B. To remain consistent with this document the prefix of a lower case s is used to denote that segment 1851 is sulfonated, hence its name s7B as is the case for the resulting polymer, vis-à-vis sP12F97B. Similarly polymer 1837 containing segments s6F and sCB is named s6F9CB but for accuracy should be s6F9B2CB.

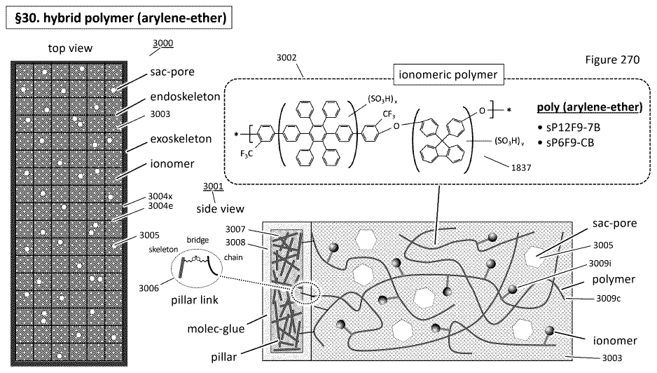

Membrane top view 3000 and membrane side view 3001 in FIG. 270 illustrate a variety of elements of ionomeric polymer 3002 hybrid PAE heteropolymer made in accordance with this invention, including separately or in combination inventive matter comprising
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 comprises poly (arylene-ether) in the linear copolymer chain topologies sP12F97B a1832 or more accurately sP12F8B7B and sP6F9CB 1837 more accurately sP6F9B2CB, optionally blended with other homopolymers, heteropolymers, copolymers, thereby controlling varying degrees of film crystallinity and anisotropy to form a hybrid copolymer;
where ionomeric polymer 3002 may comprise multi-acid sidechain 1803 serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include embedded ionic fillers;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The table below describes the construction of arylene ether polymers (PAE) hybrid membranes. Poly arylene ether heteropolymers comprise linear sequences of hydrophobic and hydrophilic sequences which may or may not be sulfonated. These heteropolymers are described structurally by a molecular code. Endoskeletons able to bond the PAE heteropolymer membranes mirror those compatible with homopolymer PAE.

Pillar materials compatible with bonding to PAEs include polystyrene (PS) and high-impact polystyrene (HIPS) which share the styrene moiety in the backbone of poly(arylene ether)s; polyamides (PAm, nylon) using appropriate adhesives or surface treatments; polyesters (PE) using compatibilizers or coupling agents containing carboxyl or anhydride groups to enhance interfacial adhesion; polyurethanes (PU) using adhesives or by interpenetrating polymer networks (IPNs) by synthesizing PU in the presence of PAE; and acrylonitrile butadiene styrene (ABS).

| ionomer | structure | endoskeleton | solvents, X-L | fillers |
|---|---|---|---|---|
| §30. arylene ether | PAE arylene | polymers: PAE, PS, HIPS, | solv: NMP, DMAc, | sac filler, CNTs, |
| heteropolymers | ether polymer | PAm, PE, PU, ABS, PC, | DMSO, DMF, PEG, | oxides, POSS, |
| sP12F9B7B | | PPO, PP, PMMA, PET | DGMME | NPs, MOFs, PIL, |
| sP6F9B2CB | | pillars; reinforcing fillers | X-L: DT, SDT, | PFPE-GO |
| | | (C-fiber, CNTs) | PFPE | |

Solvents for s(PAE)s include N-methylpyrrolidone (NMP), N,N-dimethylacetamide (DMAc), dimethylsulfoxide (DMSO), dimethylformamide (DMF), polyethylene glycol (PEG, PEO), and diethylene glycol monomethyl ether (DGMME). Cross linkers include dithiol (DT), sulfonated dithiol (SDT), and bishydroxy perfluoropolyether (PFPE). Aside from PFPE-GO crystallites, membrane fillers and dopants described previously have been omitted for the sake of brevity, and will not be repeated here.

### § 31. Functionalized Hybrid POSS-Doped Polymer IEMs.

Polyhedral oligomeric silsesquioxanes or polyhedral oligosilsesquioxanes (POSS, SSQs) is a silicon based framework with Si—O—Si linkages and tetrahedral Si vertices producing cage-like structures. Cages may take on a variety of shapes ranging from closed or open cubic shapes to hexagonal to octagonal drum-like shapes. Some configurations spontaneously rearrange. Other shapes include double decker silsesquioxanes (DDS).

Generally described as nanoparticles, polyhedral oligomeric silsesquioxanes are minute chemical molecules of 1-to-3 nm in dimension capable of modulating conductivity, catalytic, and material properties. As an membrane ionomeric additive, POSS fillers are useful in proton exchange membranes for hydrogen fuel or for direct methanol fuel cells (DMFCs). They also may form cross linkers for copolymer synthesis. Regardless of the topological configurations, pristine POSS is neither catalytic or ionomeric. Moreover, POSS does not form planar sheets needed for forming membranes. Instead POSS is a precursor to various chemical structures used for dopants and permanent fillers in membranes of other compositions.

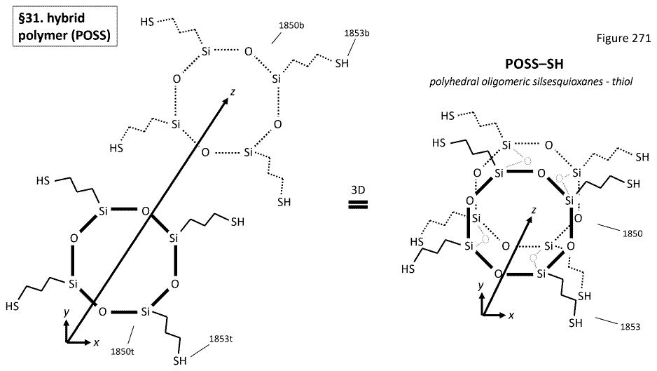

FIG. 271 illustrates quasi three dimensional renditions of a thiol (SH) doped polyhedral oligomeric silsesquioxanes. In exploded view, POSS 1850 comprises two planes of atoms—topmost ring 1850t comprising a coplanar octagonal geometry of four silicon and four oxygen atoms where the silicon atoms attack to linear carbon chains (LCCs) of three carbons with a SH 1853 terminus. An identical structure 1850b resides below the top planar ring. Silicon atoms in the top plane bond to silicon atoms in the lower plan via oxygen intermediates forming a 3D octagonal drum shape illustrated by wire frame POSS 1850.

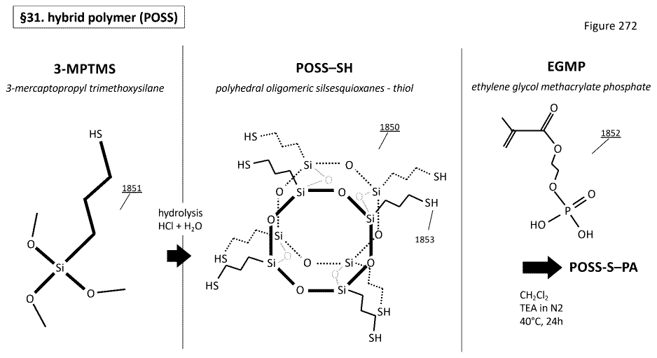

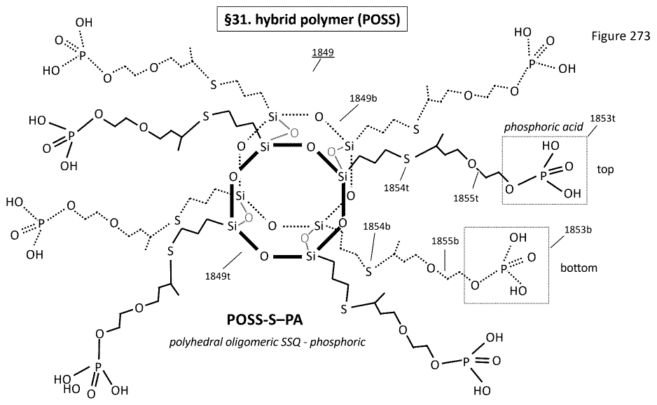

FIG. 272 illustrates one possible process for fabricating the aforementioned drum-shaped thiol doped polyhedral oligomeric silsesquioxane POSS-SH 1850 from hydrolysis of 3-mercapto-propyl trimethoxysilane (3-PTMS) 1851. In one implementation the PA-functionalized polyhedral oligomeric silsesquioxane (POSS) frameworks is formed via one-pot synthesis of methacrylic phosphonic acid using a thiol-ene click reaction. Functionalization of POSS-SH 1850 by ethylene glycol methacrylate phosphate (EGMP) 1852 in dichloromethane (CH₂Cl₂) and triethylamine (TEA) at 40° C. for 24 h results in a phosphorylated molecule specifically polyhedral oligomeric silsesquioxane-phosphoric (POSS-S-PA) 1849 comprising top plane atoms 1849t and bottom plane atoms 1849b shown in FIG. 273.

As a consequence of a substitution reaction, thiol group SH is replaced by a ligand and meta-phosphoric acid (HO₃P). Specifically in the top plane of POSS-S-PA 1849a, thiol group SH is converted to sulfur (S) 1854t then bonded to meta-phosphoric acid (HO₃P) 1853t via carbon-oxygen pendant 1855t. Similarly in the lower plane of POSS-S-PA 1849b, thiol group SH is converted to sulfur 1854b then bonded to meta-phosphoric acid (HO₃P) 1853t via carbon-oxygen pendant 1853b.

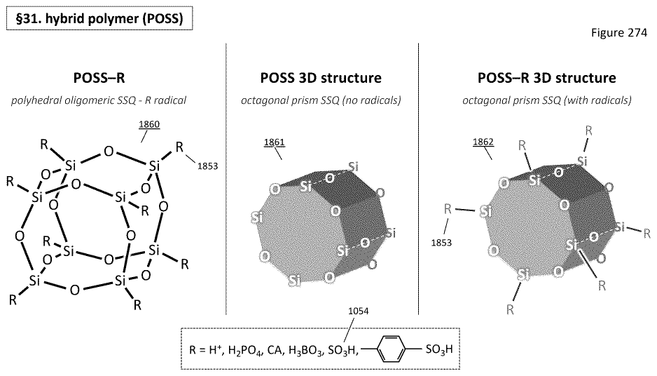

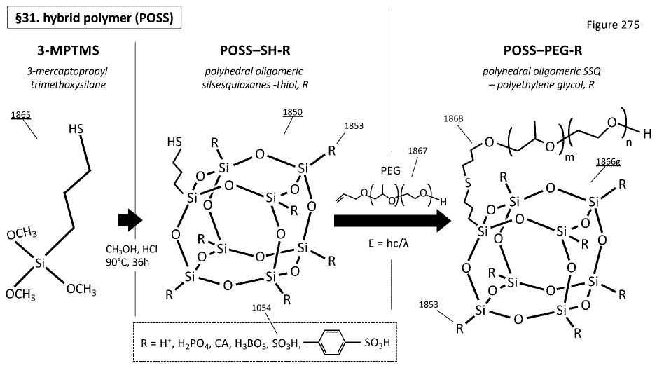

FIG. 274 illustrates three different representations of polyhedral oligomeric silsesquioxane with attached radicals (POSS-R), including wireframe model POSS 1860 with radicals R 1853; solid model POSS 1861 represented as an octagonal prism silsesquioxane shown without radicals; and solid model POSS 1862 including radicals R 1853. The radicals R may comprise hydrogen atoms atom or an organic functional group, e.g., alkyl, alkylene, acrylate, hydroxyl or epoxide units. Since most POSS molecules are primarily used as catalysts in polymer chemistry rather than as ionomers or ionomeric catalysts, the radicals R are not acids suitable for use in ion exchange membranes.

Made in accordance with this invention, polyhedral oligomeric silsesquioxane (POSS) polymers as shown can be functionalized by various ionomeric radicals including hydrogen ions H⁺, sulfonic acid (SO₃H), or sulphonated phenyl groups regardless of whether the POSS-R is in the form of a membrane, film, nanosphere, or nanocluster. Methods in substitution chemistry able to convert a non-ionomeric radical into an proton exchange group by attaching ionized hydrogen (H⁺) groups, sulfonic acid (SO₃H) 1054, sulfonated phenyl group (C₆H₆—SO₃), or other acids (not shown) such as boric acid (H₃BO₃), phosphoric acid (H₃PO₄), citric acid (CA), benzenesulfonic acid (BzSA, BzSO₃H, C₆H₆O₃S) and other acids (not shown) have been described previously and will not be repeated here.

FIG. 275 depicts a process to form a polyhedral oligomeric SSQ with a polyethylene glycol and radicals (POSS-PEG-R) 1866g with polyethylene glycol pendant 1868 formed from thermal treatment of 3-mercaptopropyl trimethoxysilane (3-MPTMS) 1865 in methanol (CH₃OH) and hydrochloric acid (HCl) at 90° C. for 36 h to produce nascent thiol-doped POSS-SH 1850 where the radical R 1853 comprises pendant R═C₃H₆HS. Subsequent treatment in light-activated polyethylene glycol (PEG) reagent 1867 the thiol 1853 pendant with polyethylene glycol (PEG) groups 1868 resulting in the molecule polyhedral oligomeric silsesquioxane-polyethylene glycol (POSS-PEG) 1866g.

Processes for thiol to PEG conversion include self-assembly of amphiphilic polyether-octa-functionalized polyhedral oligomeric silsesquioxane via a thiol-ene click reaction whereby every radical R is converted from HS to PEG. PEG is however not useful as an ionomer meaning the process must be significantly modified to produce polyhedral silsesquioxanes useful for charge transport.

Made in accordance with this invention one or several functional groups may be converted to PEG to perform chemical functions such as bonding while the remainder of the remaining radicals in the polyhedral oligomeric silsesquioxane (POSS) polymers are functionalized by various ionomeric radicals including hydrogen ions H⁺, sulfonic acid (SA, SO₃H), or sulphonated phenyl groups (Ph-SA) regardless of whether the POSS-R is in the form of a membrane, film, nanosphere, or nanocluster. In this method the POSS can be considered di-functional.

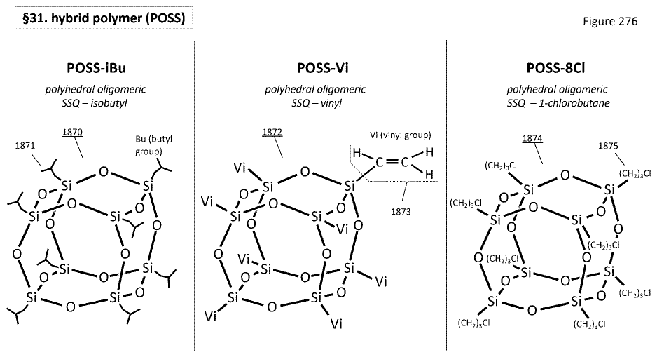

Many possible POSS configurations are based on a octahedral template of polyhedral oligomeric silsesquioxanes 1870 containing a uniform distribution of butyl 1871 pendants as depicted in FIG. 276. Without substituting any the attached butyl 1871 groups the molecule is referred to as a mono-functional polyhedral oligomeric SSQ-isobutyl (POSS-iBu) 1870. Alternative homogenously decorated monofunctional POSS frameworks include polyhedral oligomeric SSQ-vinyl (POSS-Vi) 1872 with attached vinyl groups 1873; and polyhedral oligomeric silsesquioxane-1,chlorobutane (POSS-8Cl) 1874 with attached (CH₂)₃Cl groups 1873. The designate -8Cl refers to the eight chlorine groups attached to the silicon corners of the two-layer octahedral prism.

Various monofunctional oligomeric silsesquioxane (POSS) molecules with radiating pendants comprising homo-substitute groups form functional additives for preparation of polyethylene-based composites. Without subsequent processing made in accordance with this invention to attach ionomeric functional groups comprising sulfonic acid, phosphoric acid, or other acids, these monofunctional POSS are not useful for ionomeric or catalytic purposes.

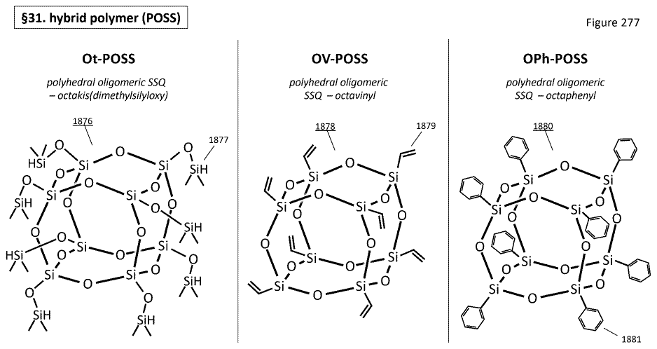

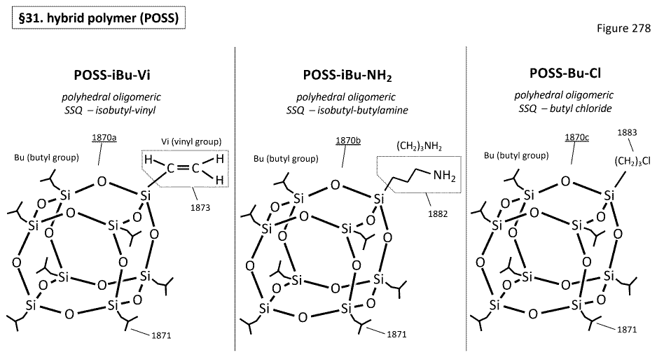

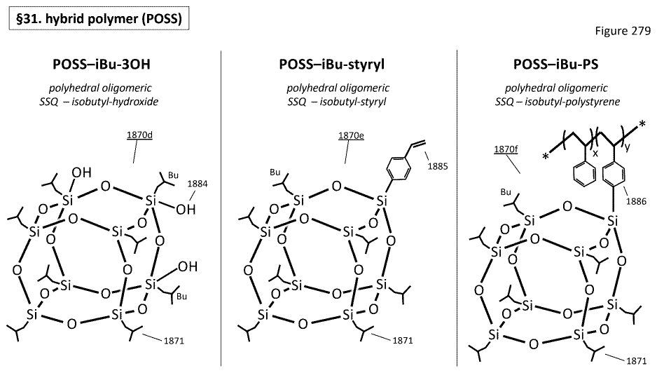

FIG. 277 illustrates three alternative monofunctional POSS. In polyhedral oligomeric SSQ-octakis(dimethylsilyloxy) (Ot-POSS) 1876 the POSS functional groups comprise silylidyne units SiH 1877 bonded to methyl groups. In polyhedral oligomeric silsesquioxane-octavinyl (OV-POSS) 1878, the POSS functional groups uniformly comprise vinyl groups 1879. In polyhedral oligomeric SSQ-octaphenyl (Ph-POSS) 1880, the POSS functional groups uniformly comprise phenyl groups 1881. Various mono-functional oligomeric silsesquioxane (POSS) molecules with radiating pendants comprising homo-substitutes are used in optical applications but are not useful at synthesis for ionomeric or catalytic purposes. Made in accordance with this invention some of the attachment points can be modified to include an electrically active functional group involving sulfonic acid (SA or Ph-SA), phosphoric acid (PA), boric acid (BA), or other acids.

Recalling the polyhedral oligomeric silsesquioxane-isobutyl (POSS-iBu) 1870 from FIG. 276, a single substation of a butyl group 1871 by a vinyl group 1873 shown in FIG. 278 produces the hybrid polyhedral oligomeric silsesquioxane-isobutyl-vinyl (POSS-iBu-Vi) 1870a. Except for the one vinyl group 1873 all other POSS radical groups remain butyl 1871. In the case of polyhedral oligomeric silsesquioxane-isobutyl-butylamine (POSS-iBu-NH₂) 1870b, one butyl group 1871 is replaced with amino group ((CH₂)₃NH₂) 1882. For polyhedral oligomeric silsesquioxane-butyl chloride (POSS-iBu-Cl) 1870c, a single butyl group is replaced by (CH₂)₃Cl) 1883. The other butyl groups 1871 remain unaltered.

These three POSS variants are considered difunctional because they contain two different types of functional groups and are thereby able to bond to two different classes of molecules within a polymer. Because neither functional group is ionomeric or catalytic, the difunctional POSS moieties are not useful in ion exchange membranes. Made in accordance with this invention, however, some of the attachment points can be modified to include an electrically active functional group involving sulfonic acid (SA or Ph-SA), phosphoric acid (PA), boric acid (BA), or other acids.

FIG. 279 illustrates three additional difunctional POSS molecules. Among them, polyhedral oligomeric silsesquioxane-isobutyl-hydroxide (POSS-iBu-30H) 1870d contains butyl groups 1871, three of which have been replaced with hydroxide 1884. In the case of polyhedral oligomeric silsesquioxane-isobutyl-styryl (POSS-iBu-styryl) 1870e, one butyl group 1871 is replaced by styryl group 1885. For polyhedral oligomeric silsesquioxane-isobutyl-polystyrene (POSS-iBu-PS) 1870f, one butyl group 1871 is replaced by polystyrene 1886. Various oligomeric silsesquioxane (POSS) molecules with radiating pendants comprising hetero-substitute groups entangled to form polystyrene-polyhedral oligosilsesquioxane (POSS) copolymers.

These three POSS variants are considered difunctional because they contain two different types of functional groups and are thereby able to bond to two different classes of molecules within a polymer. But because neither functional group is ionomeric or catalytic, the difunctional POSS moieties shown are not useful in ion exchange membranes. Made in accordance with this invention, however, some of the attachment points can be modified to include an electrically active functional group involving sulfonic acid (SA or Ph-SA), phosphoric acid (PA), boric acid (BA), or other acids.

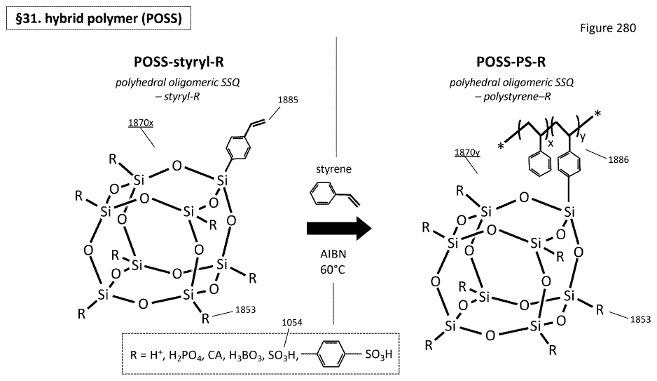

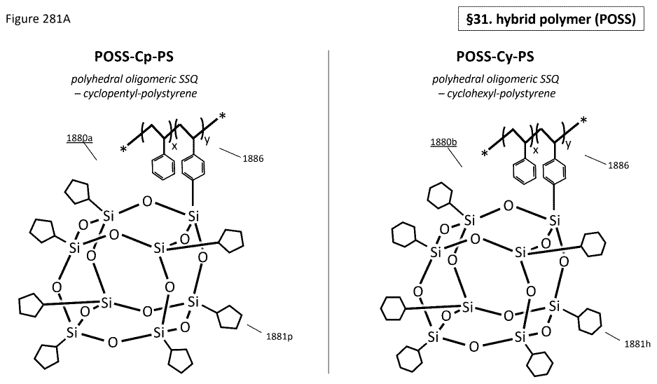

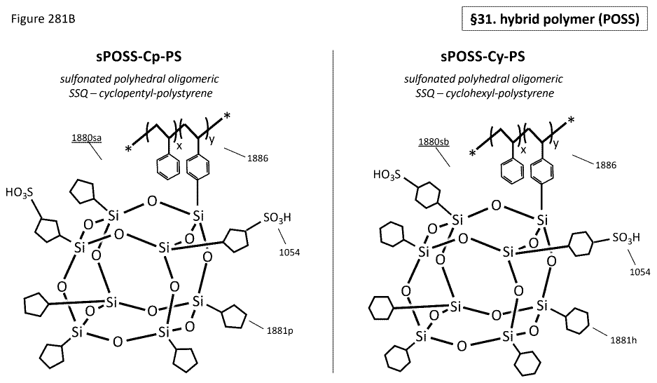

Although butyl POSS 1879 can be functionalized by styryl 1885 and polystyrene 1885 groups, a more generic difunctional version shown in FIG. 280, replaces butyl 1871 group with a generic radical R 1853. Containing a generic radical R, POSS-styryl-R 1870x comprises polyhedral oligomeric silsesquioxane-styryl-R with radical R 1853 and styryl group 1885. Treatment in styrene (vinylbenzene) and azobisisobutyronitrile (AlBN) at 60° C. converts POSS-styryl-R 1870x into polyhedral oligomeric silsesquioxane-polystyrene-R (POSS—PS—R) 1870y with polystyrene 1886. Made in accordance with this invention, polyhedral oligomeric silsesquioxane (POSS) polymers as shown containing an uncommitted radical R can be functionalized by various ionomeric radicals including hydrogen ions H⁺, sulfonic acid (SO₃H), or sulphonated phenyl groups regardless of whether the POSS-R is in the form of a membrane, film, nanosphere, or nanocluster.

FIG. 281A illustrates two monofunctional polystyrene POSS variants, namely polyhedral oligomeric silsesquioxane-cyclopentyl-polystyrene (POSS-Cp-PS) 1880a comprising five-sided cyclopentyl group 1881p and functional group polystyrene 1886; and polyhedral oligomeric silsesquioxane-cyclohexyl-polystyrene (POSS-Cy-PS) 1880b comprising six-sided cyclohexyl groups 1881h and functional group polystyrene 1886.

FIG. 281B illustrates modifications of these polystyrene POSS moieties made in according with this invention to add an ionomeric group such as sulfonic acid 1054 onto the aromatic rings. Specifically for sulfonated polyhedral oligomeric silsesquioxane-cyclopentyl-polystyrene (sPOSS-Cp-PS) 1880sa, sulfonic group 1054 attaches to one or more cyclopentane groups. Similarly in polyhedral oligomeric silsesquioxane-cyclohexyl-polystyrene (sPOSS-Cy-PS) 1880sb comprising six-sided cyclohexyl (benzene) groups 1881h and functional group polystyrene 1886 sulfonic group attaches to one or more rings 1881h.

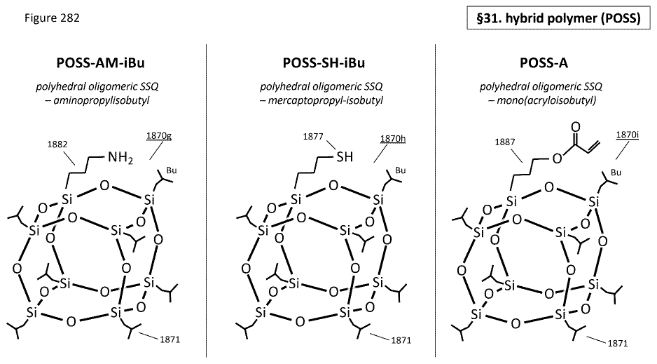

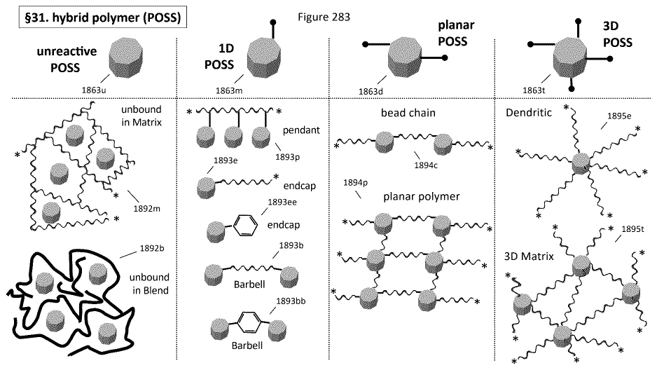

Three other butyl-based difunctional POSS illustrated in FIG. 282 includes polyhedral oligomeric silsesquioxane-aminopropylisobutyl (POSS-Am—NH₂) 1870g comprising seven butyl groups and one amino group 1882; polyhedral oligomeric silsesquioxane-mercaptopropyl-isobutyl (POSS-SH) 1870h comprising seven butyl groups and one mercapto (SH) group 1877; and polyhedral oligomeric silsesquioxane-mono(acryloisobutyl) (POSS-A) 1870i comprising seven butyl groups and one butyl acrylate group 1887.

These three POSS variants are considered difunctional because they contain two different types of functional groups and are thereby able to bond to two different classes of molecules within a polymer. But because neither functional group is ionomeric or catalytic, the difunctional POSS moieties shown are not useful in ion exchange membranes. Made in accordance with this invention, however, some of the attachment points can be modified to include an electrically active functional group involving sulfonic acid (SA or Ph-SA), phosphoric acid (PA), boric acid (BA), or other acids.

FIG. 283 contrasts four classes of POSS geometric topographies—unreactive POSS 1863u, 1D POSS 1653m, planar POSS 1763d, and 3D POSS 1863t. Unreactive POSS 1863u comprises unfunctionalized POSS nanoparticles than form no chemical or ionic bonds and therefore do not cooperate in conduction or chemical reactions, but may affect film morphology including density, porosity, and crystallinity. Unreactive POSS 1663u examples include unbounded POSS located interstitially in polymer matrix 1892m or intercalated within polymer blend 1892b.

One dimensional POSS 1863m which may be considered as point-contact POSS containing a single bonding point. As such, they do not define or impact polymer geometry but only attach to a membrane ‘as formed’. Representative 1D topological configurations of POSS 1863m include pendant 1863p; endcaps 1863e and 1893ee; along with barbells 1893b and 1893bb.

Planar POSS 1863d aka 2D POSS have two or more connections in the same plane. As such, 2D POSS cab form linear strings such as bead chains 1894c, sheets and planar polymers 1784p. Embedded within a membrane planar POSS can enhance electrical conductivity and reduce fuel crossover but do not add significant structure support as no bonds exist orthogonal to the bonding plane. The 3D version of POSS 1863t comprise at least three bonds, one or more in each of three-axis. Examples include like dendritic webs 1895e and 3D matrix 1895t.

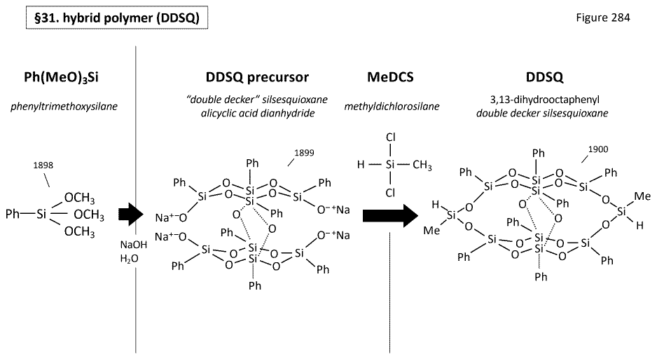

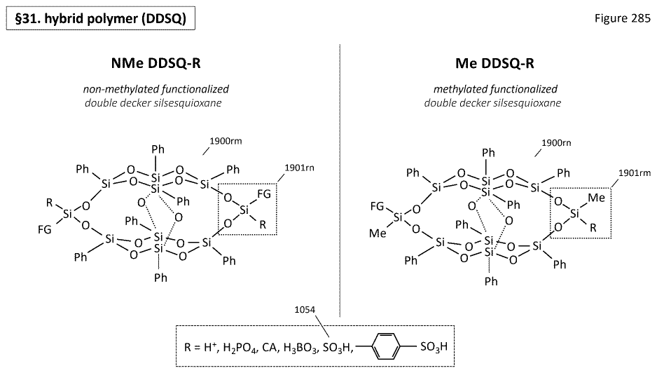

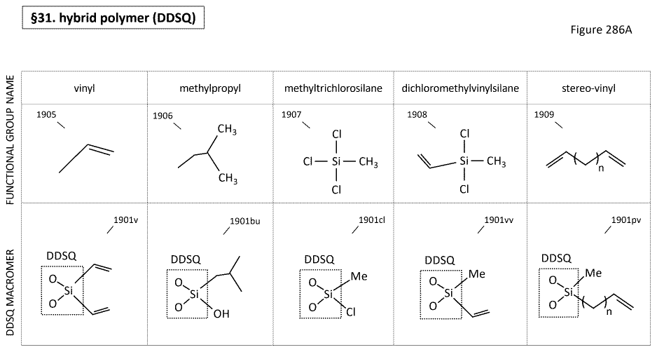

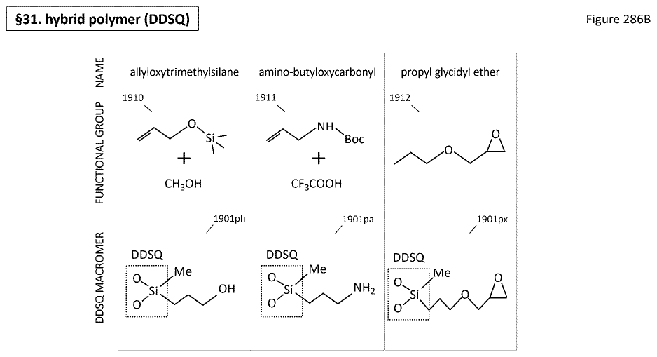

Another class of oligomeric silsesquioxane molecules is that of double-decker silsesquioxane (DDSQ). Less cage-like than POSS, DDSQs form bird-nest like structures able to capture and gold other molecules or large atoms called guests. As shown in FIG. 284, phenyltrimethoxysilane (Ph(MeO)₃Si, C₉H₁₄O₃Si) 1898 treated in sodium hydroxide (NaOH) forms DDSQ precursor 1899 comprising silsesquioxane alicyclic acid dianhydride. Subsequent mixing with methyl-dichlorosilane (MeDCS, SiHCl₂CH₃) produces DDAQ 1900 comprising 3,13-dihydrooctaphenyl double decker silsesquioxane.

Although DDSQ 1900 is considered difunctional because they contain two different types of functional groups, namely phenyl (Ph) and methyl (Me) groups, because neither functional group is ionomeric or catalytic, pristine DDSQ 1900 is not useful in ion exchange membranes. Made in accordance with this invention, however, some of the attachment points can be modified to include an electrically active functional group involving sulfonic acid (SA or Ph-SA), phosphoric acid (PA), boric acid (BA), or other acids.

Other difunctional DDSQ variants shown in FIG. 285 include non-methylated functionalized double decker silsesquioxane NMe DDSQ-R 1900rn with radical R 1901rn and methylated functionalized double decker silsesquioxane 1900rm with methylated radical R 1901rm. Made in accordance with this invention, double decker silsesquioxane (DDSQ) polymers as shown can be functionalized by various ionomeric radicals including hydrogen ions H⁺, sulfonic acid (SO₃H), or sulphonated phenyl groups regardless of whether the POSS-R is in the form of a membrane, film, nanosphere, or nanocluster.

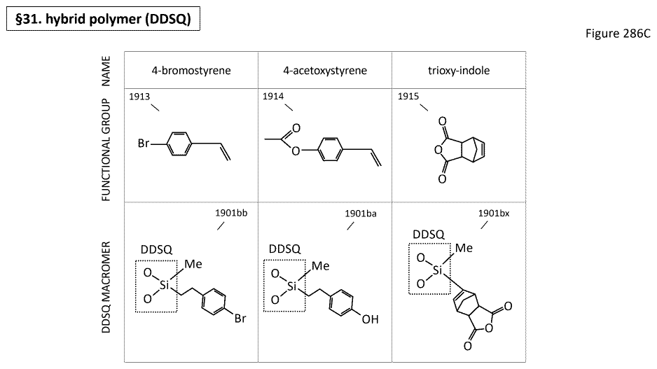

In the illustration, the term FG refers to functional group, to be distinguished from an organic, ionomeric, or catalytic radical R. Various functional groups shown in FIG. 286A include vinyl group 1905 derived from DDSQ macromer 1901v, methylpropyl 1906 derived from DDSQ macromer 1901bu, methyltrichlorosilane 1907 derived from DDSQ macromer 1901cl, dichloromethyl-vinylsilane 1908 derived from DDSQ macromer 1901vv, stereo vinyl 1909 derived from DDSQ macromer 1901pv.

Other functional groups shown in FIG. 286B include allyloxytrimethylsilane 1910 derived from DDSQ macromer 1801ph, amino-butyloxycarbonyl 1911 derived from DDSQ macromer 1901pa, and propyl glycidyl ether 1912 derived from DDSQ macromer 1901px. Similarly FIG. 286C illustrates the functional group 4-bromostyrene 1913 derived from DDSQ macromer 1901bb, 4-acetoxystyrene 1914 derived from DDSQ macromer 1901ba, and trioxyindole 1915 derived from DDSQ macromer 1901bx.

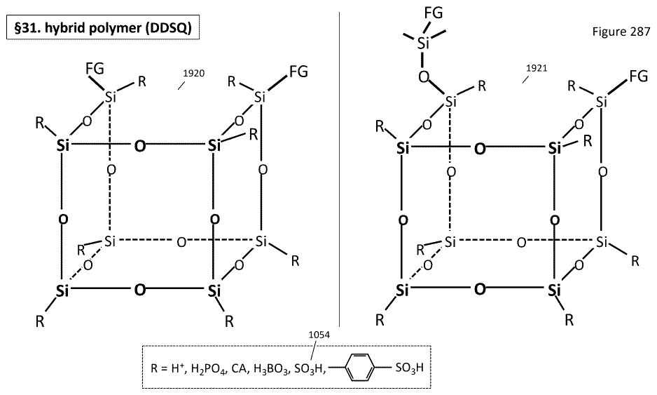

Cubic DDSQ illustrated in FIG. 287 include two exemplary difunctional variants 1920 and 1921 with radical R and functional groups FG. Made in accordance with this invention, double decker silsesquioxane (DDSQ) polymers as shown can be functionalized by various ionomeric radicals including hydrogen ions H⁺, sulfonic acid (SO₃H) 1054, or sulphonated phenyl groups regardless of whether the POSS-R is in the form of a membrane, film, nanosphere, or nanocluster.

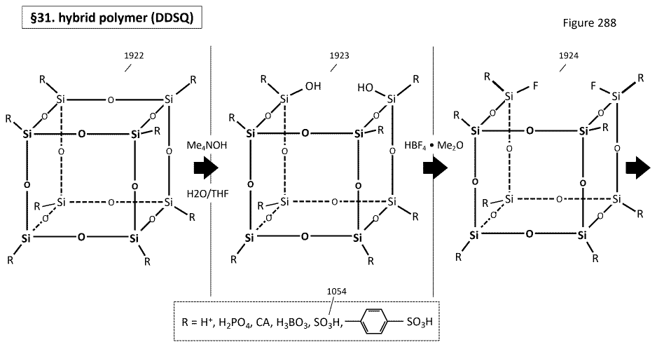

FIG. 288 illustrates an exemplary synthesis of functionalized cubic DDSQ commencing with closed cube 1922 with external radicals R. Treatment by tetramethylammonium hydroxide (Me₄NOH) and hydronated tetrahydrofuran (THF) cleaves a single Si—O—Si linkage in DDSQ cube 1923 (R₈Si₈O₁₂), opening one cube edge, preserving the stereochemistry of its constituent endo disilanols while replacing the dangling bonds with OH groups. Subsequent treatment in tetrafluoroboric acid and dimethyl ether (HBF₄·Me₂O) substitutes fluorine for OH in cube 1924.

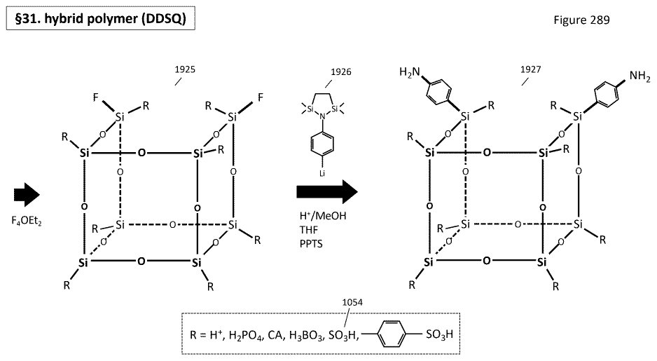

Thereafter tetrafluoride ethylene oxide (F₄EtO) nucleophilic substitution reaction inverting the silicon corner bonds of cube DDSQ 1924 from endo-fluorine isomers into exo-fluorine bonds. In the final phase the exo-fluorine atoms are substituted by anilino groups through the substitution with lithiophenyl-N-1,1,4,4,-tetramethyldisilylazacyclopentane 1926 and deprotection by methyl alcohol (MeOH), tetrahydrofuran (THF), and pyridinium p-toluene sulfonate (PPTS) producing dianilino DDSQ 1927 macromers as shown in FIG. 289.

Made in accordance with this invention, the cubic double decker silsesquioxane (DDSQ) polymers as shown can be functionalized by various ionomeric radicals including hydrogen ions H⁺, sulfonic acid (SO₃H), or sulphonated phenyl groups regardless of whether the DDSQ-R is in the form of a membrane, film, nanosphere, or nanocluster.

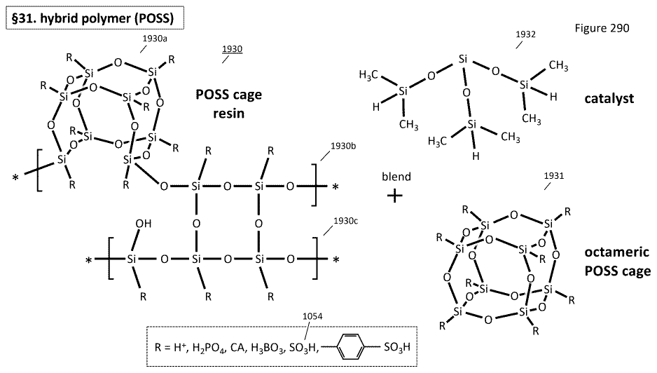

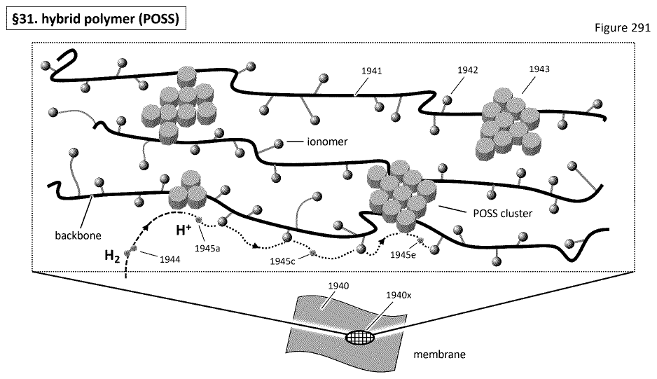

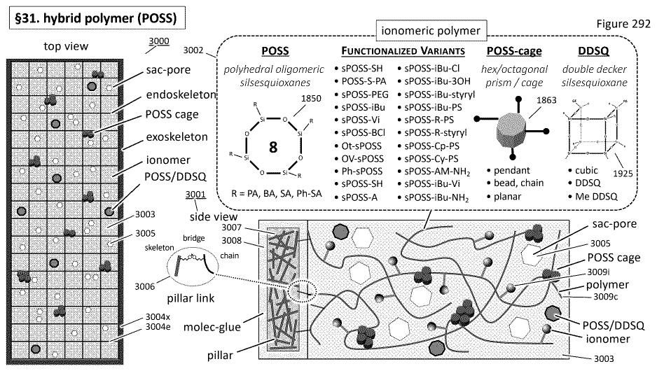

FIG. 290 illustrates the blending of three components into POSS based polymer coatings for solar cells as published in NASA whitepaper via a 2007 Hybrid Plastics whitepaper. The coating is composed of (a) POSS cage resin 1930 comprising a partial cage 1930a, an attached linear silicate chain 1930b, and a cross linked silicate chain 1930c all populated by radical R links, (b) catalyst 1932, and (c) previously described octameric POSS cage 1931, also decorated by radical R linkages.

Although the coating is intended to enhance solar adsorption in photovoltaic cells, when functionalized by various ionomeric radicals including hydrogen ions H⁺, sulfonic acid (SO₃H), or sulphonated phenyl groups made in accordance with this invention, the material can be repurposed for use in ionomeric membranes.

Similarly, FIG. 291 illustrates the structure of a POSS coated Nafion® hybrid membrane as described comprising an in situ implanted cross-linked functionalized POSS blocks in Nafion® for high performance direct methanol fuel cells. By repurposing the silsesquioxane via functionalization of POSS using methods made in a accordance with this invention, ion exchange membrane 1940 depicted in closeup 1940x contains a polymeric backbone 1941, ionomeric pendants 1942, and ionomeric or catalytic POSS permanent fillers 1943.

As depicted the presence of POSS can enhance conduction by providing added conduits for hopping conduction or alternate pathways to catalyze unionized fuel leaking into the membrane. For example incoming hydrogen gas 1944 is ionized into H⁺ protons 1945a which immediately is absorbed by the nearest ionomer 1942 releasing another proton that hops to the next ionomer changing to proton 1945c.

This electron changes in the next ionomer and again into proton 1945e when it encounters ionomeric POSS 1943. Since protons are indistinguishable, there is no way to identify protons 1943a formed by ionization from protons 1943c emitted by ionomers 1942 or those protons 1963e emitted from ionomer groups on POSS 1943.

Indirect evidence proving the POSS role in conduction can be confirmed by correlating increases in conductance to the doping density of inventive ionomeric POSS fillers within an IEM. The role of inventive catalytic POSS is best suited as a coating atop the polymer membrane. Increased catalytic POSS density in the coating causes an corresponding yet asymptotic increase in the free H⁺ ions entering the membrane also contributing to enhanced film conductance. This cooperative co-conduction mechanism occurs independently of the type of polymer used to form the membrane, so long that POSS nanoparticles are able to bond onto the membrane matrix.

In other words, the application of POSS and DDESQ as membrane fillers is agnostic to polymer chemistry. Examples of polymers treatable with POSS macromer doping, represent a wide spectrum including polyimide (PI), polyureas, poly(N-isopropylacrylamide, poly(N-vinylpyrrolidone), poly(hydroxyether of bisphenol A) (PPh), epoxy resin (EPX), poly(aryl ether sulfone) (PSf), vinylene-arylene copolymers (Vi-co-Ary), poly(azomethine)s (PAz), poly(cyclo-octadiene)s, polysiloxanes (PSiX), polybenzoxane (PBz), and phenol resins. Not all of the polymers form membranes but may still be used as nano-coatings atop other ionomeric polymers.

In summary membrane top view 3000 and membrane side view 3001 in FIG. 292 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 comprises a fluorocarbon such as PFSA or hydrocarbon, optionally blended with other homopolymers, heteropolymers, copolymers, thereby controlling varying degrees of film crystallinity and anisotropy to form a hybrid copolymer;
where ionomeric polymer 3002 may comprise pendants influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups, along with phosphoric acid, boric acid, and others;
where ionomeric polymer 3002 may include embedded ionic fillers including polyhedral oligomeric silsesquioxanes (POSS) 1850 such as POSS-SH, POSS-S-PA, POSS-PEG, POSS-iBu, POSS-Vi, POSS-BCl, Ot-POSS, OV-POSS, Ph-POSS, POSS-iBu-Vi, POSS-iBu-NH₂, POSS-iBu-CI, POSS-iBu-30H, POS-iBu-styrl, POSS-iBu-PS, POS-R-styrl, POSS-R—PS, POSS-Cp-PS, POSS-Cy-PS, POSS-Am—NH₂, POSS-SH, POSS-A; hexagonal and octagonal POSS prisms and cages 1863 such as pendant, endcap, barbell, bead chain, planar, dendritic, and 3D matrix topologies; and double-decker silsesquioxane (DDSQ) POSS 1925 including cubic, non-methylated, and methylated POSS; any of which may be decorated with ionomer groups;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

As a permanent filler and dopant, functionalized POSS and DSSQ can be introduced into any membrane polymer either fluorocarbon or hydrocarbon. Material selection of the endoskeleton, solvents, catalysts, and cross-linkers relate to the membrane polymer, not the POSS dopants.

Polyhedral oligomeric and double-decker silsesquioxane based permanent fillers and dopants (POSS and DDSQ) as described include POSS-PA, POSS-R, POSS-FG-R, POSS-iBu-FG-R, POSS-styryl-R, POSS—PS—R, POSS-FG1-FG2-R, DDSQ-R, and DDSQ-FG-R where R may comprise any ionomer such as sulfonic acid (SA), phenylated sulfonic acid (Ph-SA), phosphoric acid (PA), boric acid (BA), citric acid (CA) and other acids. Aside from POSS and DDSQ fillers, membrane fillers and dopants described previously have been omitted for the sake of brevity, and will not be repeated here.

| ionomer | structure | endoskeleton | solvents, X-L | fillers |
|---|---|---|---|---|
| §31. POSS/DSSQ | POSS/DSSQ | polymer: matched | solv: catalysts, | POSS fillers: POSS-PA, |
| doped polymers | doped hybrid | to IEM polymer. | used in forming | POSS-R, POSS-FG-R, |
| PFSA-PTFE | polymer | pillar: reinforcing | polymers match | POSS-iBu-FG-R, POSS- |
| PFIA | | fillers (C-fiber, | membrane, not | styryl-R, POSS-PS-R, |
| PFSA-PVA-PTFE | | CNTs) | filler | POSS-FG1-FG2-R, |
| SPAES, sPEEK, sPEES | | | X-L: reagents | DDSQ-R, DDSQ-FG-R |
| SPVA, sPBI, sCS | | | matching | other fillers: sac filler, |
| | | | membrane | CNTs, oxides, POSS, |
| | | | polymer | NPs, MOFs, PIL |

### § 32. Functionalized Hybrid Nano-Treated Polymer IEMs.

Nanostructures can be used to impact the electrical and material properties of polymer membranes either as a filler and dopant or as a coating. Where catalysts, barrier materials, and protective scavengers are most effective as coatings, nanoparticle ionomeric dopants and permanent fillers are more effective when integrated into the polymer bulk itself.

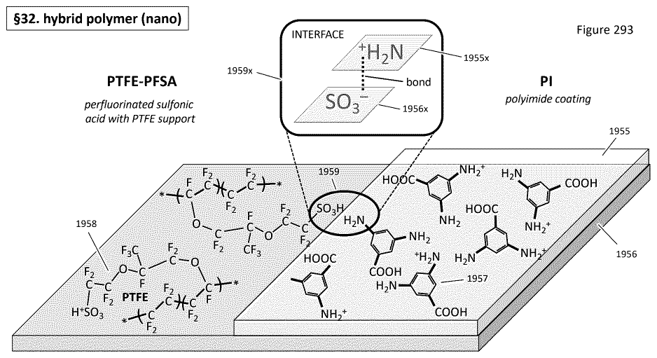

FIG. 293 illustrates the bonding between a coating and the membrane it protects. In the example shown, a polyimide (PI) layer 1955 is deposited atop membrane 1956 comprising a polymeric chain 1968 of perfluorinated sulfonic acid with integral PTFE support. Expanded view 1959x illustrates H₂N⁺ ions in the PI layer 1955x forms an electrostatic bond with SO₃H− ions in the PTFE layer 1956x. Interfacial polarization between the two layers has been postulated to explain observed reductions in hydrogen crossover in DMFCs although interfacial surface states and columbic scattering may also be may also be responsible. Regardless of the mechanism, the application of nanocoatings of polyimide reduces hydrogen crossover. As another embodiment of this invention, a nanocoating may be blended with PTFE nanospheres, bismuth compounds, metal-organic frameworks (MOFs) and boron nitride, not only to reduce fuel cross over but to mitigate the diffusion of nitric oxide (NO) and reduce the incidence of catalyst poisoning therefrom.

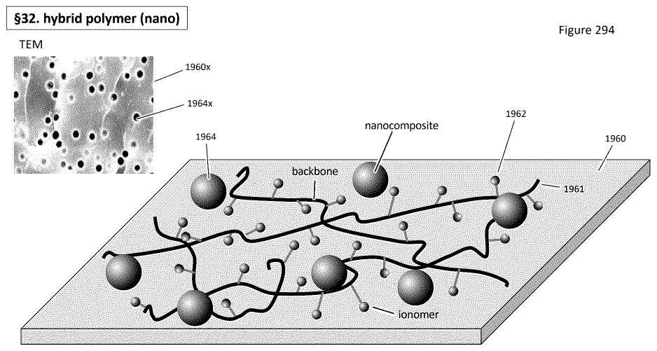

Rather than depositing nanostructures upon the surface of a IEM, the structures may be integrated within as permanent fillers introduced during molding and polymerization. FIG. 294 illustrates nanocomposite doping of a membrane. As shown, membrane 1960 comprises polymer backbones 1961, ionomers 1962, and nanocomposite dopants 1965. Transmission electron micrograph (TEM) showing the relative size of nanocomposites 1964x within membrane 1960x.

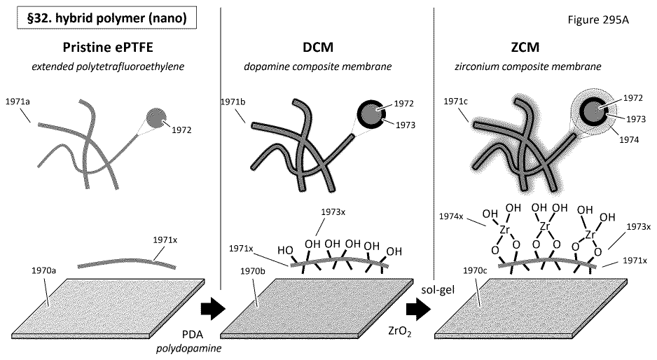

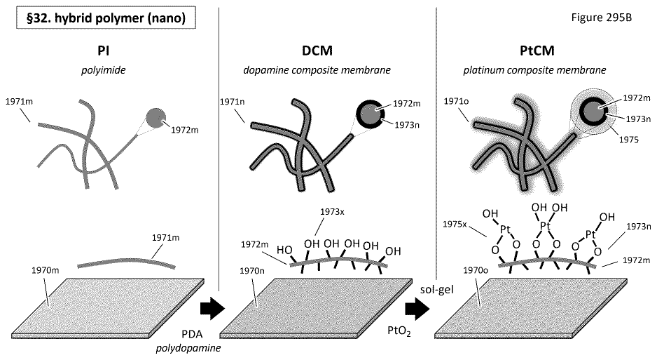

Aside from coating membranes or acting as a filler, nanocoatings can also coat individual polymer chains. As shown in FIG. 295A, extended polytetrafluoroethylene (pristine ePTFE) 1971a forms membrane 1970a comprising uncoated polymer 1971a. As a homopolymer, for the sake of this discussion, the cross sectional core 1972 of ePTFE with a width of around 1 nm. Viewed at a resolution of 10 nm, ePTFE can therefore can be considered as homogenous. In the first post polymerization step as shown, pristine ePTFE 1971b is treated by polydopamine (PDA) to form dopamine composite polymer 1971b comprising dopamine composite membrane (DCM) 1970b.

In cross section dopamine composite polymer 1971b comprises its uniform core 1972 of ePTFE encased by a dopamine coating 1973. A higher resolution cross sectional view reveals the ePTFE chain 1971x is coated by OH radicals 1973x. For clarity's sake the OH groups are shown on only one side of ePTFE chain 1971x but in reality concentrically encase the polymer chain. In the second step, a sol-gel process in zirconium oxide (ZrO₂) coats dopamine composite polymer 1971b with a layer of zirconium 1974 shown in cross section 1974x thereby forming composite membrane (ZCM) 1970c comprising zirconium composite polymer 1971b.

The ZCM coating as describes provides beneficial characteristics to a membrane with antimicrobial and antioxidant attributes. One such process for sol-gel modification of a PTFE membrane is whereby expanded polytetrafluoroethylene skeletons are modified by a surface sol-gel process. While the sol-gel process can modify a polymer's backbone, it does not directly apply to ion exchange membranes but instead is more applicable to biomedical applications and is not in the same field of art as fuel cells and electrolyzers.

An alternative process shown on FIG. 198B applicable to electrical devices and made in accordance with invention, is to coat a polymer mainchain with a catalytic rather than an antibacterial coating. In the example shown the mainchain of an uncoated polymer 1971m comprising polyimide (PI) or polyvinyl acetate (PVA) is used to form membrane 1970m. As a homopolymer, for the sake of this discussion, PI polymer cross section 1972m is around 1 nm. Viewed at a resolution of 10 nm, polyimide can therefore can be considered as homogenous. In the first post-polymerization process step, a linking molecule such as polydopamine (PDA) or polyvinyl alcohol (PVA) is used to encase uncoated polymer 1971m with dopamine shell 1971n. A cross sectional view reveals the dopamine shell 1971n comprises OH groups 1973x attached to polymer 1971m. For clarity's sake the OH groups are shown on only one side of ePTFE chain 1971x but in reality concentrically encase the polymer chain.

In a second step platinum dioxide (PtO₂, platinum(IV) oxide hydrate) reacts with the exposed dopamine hydroxide groups 1973n to form a layer of platinum 1975x, some of which are coated by OH groups formed by Pt—O groups bonding to free hydrogen during the reaction. In so doing outer platinum outer shell 1975 concentrically encases the shell of dopamine hydroxide groups 1973n and the polymer 1972m core. The result is platinum composite 1971o forming catalytic membrane or coating 1970o. In an alternative process palladium oxide (PdO) or titanium dioxide (TiO₂) are used to form the catalyst layer.

The attachment to the intermediate bonding layer occurs through the oxygen groups of the metal, not by oxidizing the metal itself. As such, the process can be performed at relatively low temperatures. If the membrane comprises scavenger metals intended to protect the catalyst layer of the CCM from carbon monoxide poisoning, the catalyst may be replaced by nickel, cobalt, iron or other low cost metals using NiO, FeO, or CoO oxides as the reactants. Alternatively both catalyst and scavenger may be intermixed in an desired ratio.

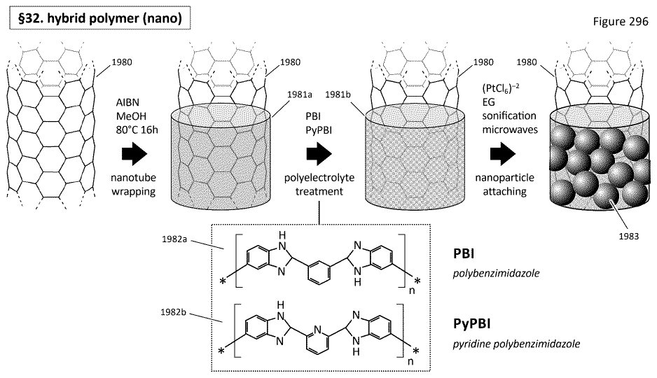

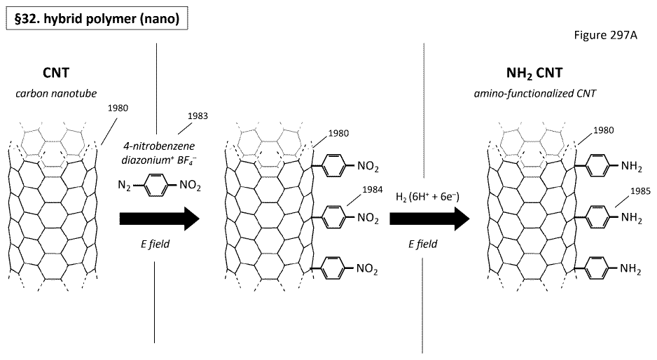

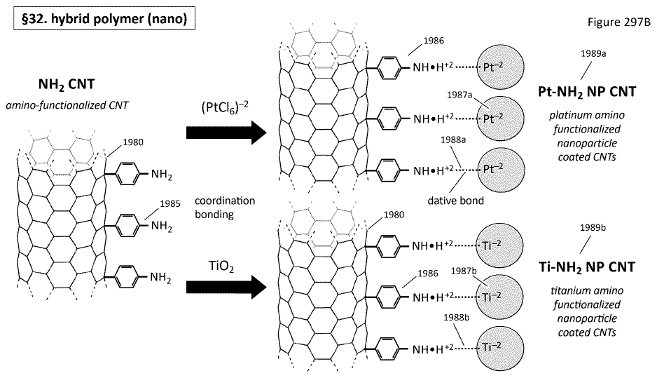

Another form of nanostructure treatment involves carbon nanotubes. Although the carbon nanotubes are larger than nanoparticles, they can be functionalized by nanoparticles attached to their surfaces. The functionalized nanotube can then be used as a permanent filler in membranes to enhance catalytic and ionomeric activity. As illustrated in FIG. 296 carbon nanotube 1980 is coated by a bonding layer 1981a herein referred to as nanotube wrapping comprising a 16 h surface treatment at 80° C. in (azobisisobutyronitrile) AlBN and methanol (MeOH).

By wrapping the nanotube with a negatively charged polyelectrolyte bonding layer 1981a, a positively charged monolayer 1981b can then be deposited onto the nanotube. Exemplary electrolytes include polybenzimidazole (PBI) 1982a and pyridine polybenzimidazole (PyPBI) 1982b. Once deposited positively charged monolayer 1981b serves as the real template for nanoparticle adsorption via electrostatic interactions, shown as the nanoparticle attaching step. The process results in a nanoparticle (NP) coated 1983 coated nanotube 1980.

One type of nanoparticles comprises Pt or Pd based alloys beneficial as catalysts in supporting electrochemical reactions. While free metal NPs are unstable and prone to losing their catalytic potential through irreversible aggregation during electrochemical processes, affixing catalytic nanoparticles to a framework such as a CNT greatly reduces these aging effects. For example, sonification and microwave irradiation of platinum NPs comprising hexachloroplatinate (PtCl₆)⁻² and ethylene glycol (EG).

Another method to functionalize carbon nanotubes is electrochemical functionalization of the CNT surface. As shown in FIG. 297A, this process involves treatment of CNT 1980 with 1983 4-nitrobenzenediazonium tetrafluoroborate (C₆H₄N₃O₂⁺BF₄⁻) in an electric field, by grafting a monolayer of para-nitrobenzene 1984 onto the CNT exterior sidewall. Subsequent application of electric fields ionizes hydrogen into H⁺ converting NO₂ into amino NH₂ and transforming para-nitrobenzene 1984 functional groups into aminobenzene 1985. As shown in FIG. 297B, through coordination bonding of (PtCl₆)⁻² to CNT aminobenzene groups, divalent platinum nanoparticles Pt⁻² 1987a form dative bonds 1988a to ionized amine groups 1986 resulting in platinum amino functionalized nanoparticle coated CNTs 1989a. Similarly through coordination bonding of TiO₂ to CNT aminobenzene 1985 groups, divalent platinum nanoparticles Ti₂ 1987b form dative bonds 1988b to ionized amine groups 1986 resulting in titanium amino functionalized nanoparticle coated CNTs 1989b. Functionalized carbon nanotubes made in accordance with invention include applications in proton exchange membrane fuel cells (PEMFCs), in electrolysis, and in electrodialysis.

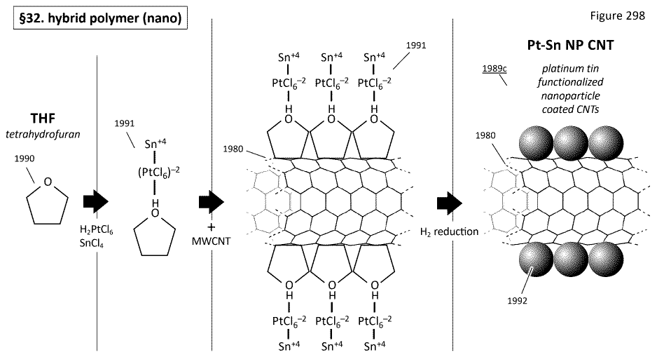

Another process for synthesizing platinum catalyst nanoparticle coated carbon nanotubes is depicted in FIG. 298. Instead of attaching premade nanoparticles to a CNT, an alternative method involves attaching a platinum-tin group to an aromatic ring such as benzene or a cyclopentane group, affixing the ring to a carbon nanotube, then forming the metal nanoparticle in situ. As shown, starting with tetrahydrofuran 1990, treatment in chloroplatinic acid (H₂PtCl₆) and stannic chloride aka tin(IV) chloride (SnCl₄) results in an inorganic-organic NP precursor 1991.

By protonating THF-pretreated CNTs, adsorption of (PtCl₆)⁻² and Sn⁴ ions onto sterically-accessible oxygen sites results electrostatic autonomous assembly of nanoparticles in hydrogen environments. The self-arranging Pt—Sn nanoparticles 1992 naturally adhere multiwalled carbon nanotube (MWCNT) 1980 thereby forming platinum-tin functionalized nanoparticle coated CNTs 1989c.

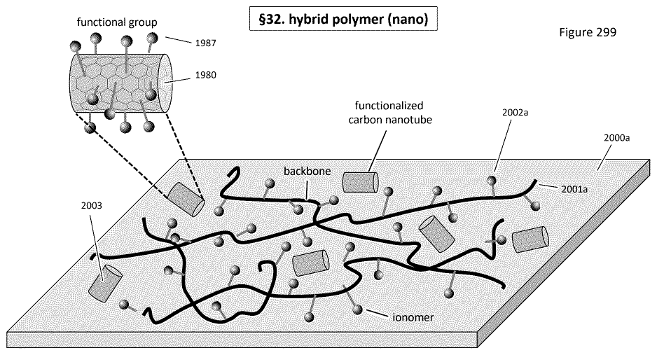

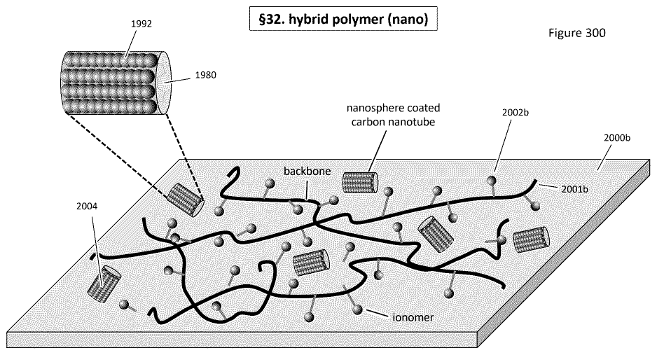

Made in accordance with this invention, FIG. 299 illustrates a polymeric membrane 2000a comprising polymer backbones 2001a with ionomers 2002a doped by permanent nano fillers 2003 comprising CNTs 1980 containing functional groups 1987. Made in accordance with this invention, FIG. 300 illustrates a polymeric membrane 2000b comprising polymer backbones 2001b with ionomers 2002b doped by permanent nano fillers 2004 comprising CNTs 1980 containing functional groups 1992.

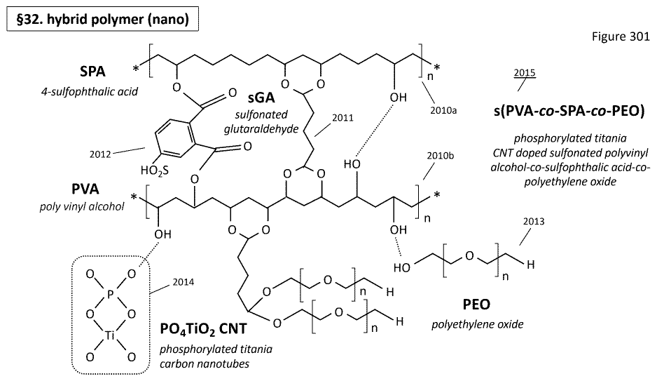

FIG. 301 illustrates the structure of phosphorylated titanium nanotubes used in a compound IEM including a plethora of ion exchange groups. As shown, the exemplary membrane includes a copolymer of phosphorylated-titania-CNT doped sulfonated polyvinyl alcohol-co-sulfophthalic acid-co-polyethylene oxide s(PVA-co-SPA-co-PEO) 2015 comprising polyvinyl alcohol (PVA) 2010b cross-linked to sulfophthalic acid (SPA) 2010a by cross-linking molecule sulfonated glutaraldehyde (sGA) 2012. Polyvinyl alcohol (PVA) 2010b also forms covalent linkage to multiple polyethylene oxide (PEO) chains 2013. Permanent filler and dopants comprising phosphorylated titania carbon nanotubes (PO₄TiO₂) 2104 are embedded within the copolymer 2015 to modulate conductivity.

Aside from cation conduction via hydrogen and methanol, the structure of phosphorylated titanium nanotubes can be adapted to a AEM fuels including hydrogen borohydride fuel cells. Titanium oxide functionalized nanotubes can also be used in sulfonated PVA/PEO membranes. Nanotechnology can contribute to the ex post facto modification of polymers such as radiation induced grafted polymers.

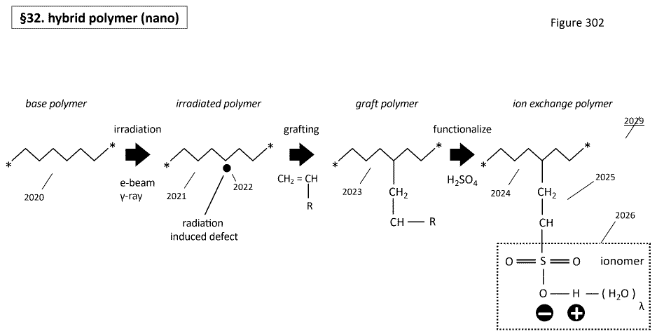

Nanoengineering can also be used to form a nanograft to attach ionomers to polymeric mainchains. As shown in FIG. 302, a base polymer 2020 irradiated by gamma rays or e-beams results in irradiated polymers 2021 with a radiation induced defects 2022. Grafting with the CH₂═CH—R pendant results in a graft polymer 2023. Functionalized by H₂SO₄ pendant 2025 bonds to ionomer 2026 resulting in ion exchange membrane 2029. Aside from high cost and low throughput, the one problem with radiation induced graft points is it is difficult to predict the density of the damage sites and their locations along a polymer mainchain.

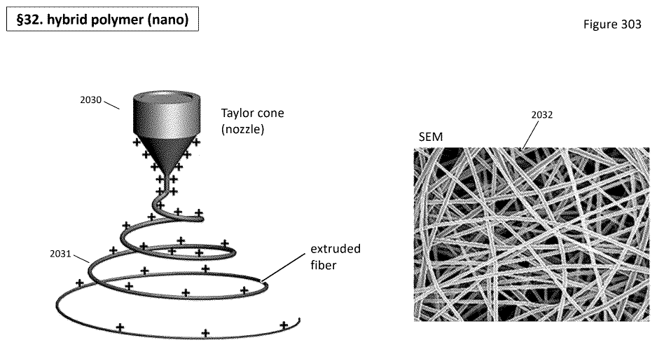

Another nanotechnology potentially applicable for doping ion exchange membranes is electrospinning. In electrospinning shown in FIG. 303 a nanofiber 2031 is extruded through a electrically charged nozzle 2020 called a Taylor cone producing a fibrous mesh or mat. The nanofiber mat or mesh can then be added as filler to another polymer to form a composite hybrid membrane, e.g. using sulfonated polystyrene. As the polymer is molded around the fiber, the nanofiber material must be compatible with the polymer chemistry ideally forming covalent or at least extensive hydrogen bonds between the two materials.

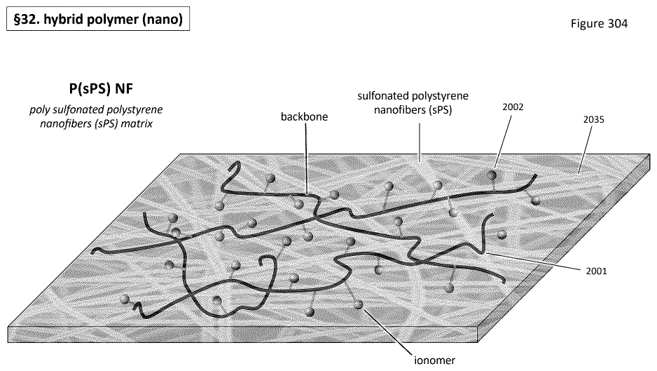

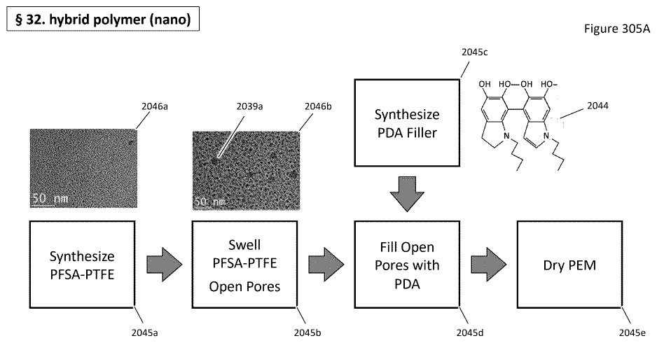

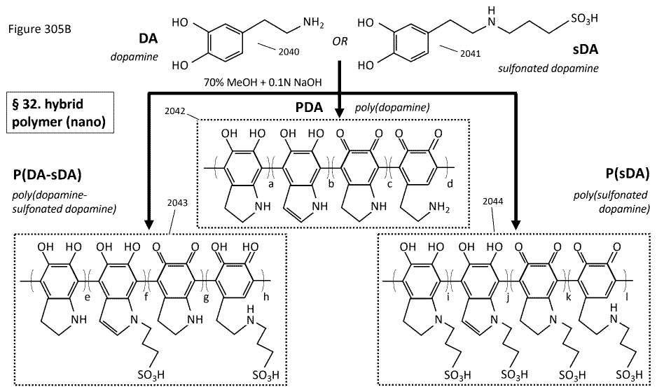

FIG. 304 depicts an artistic rendition of a sulfonated polystyrene fiber network formed on a dissimilar ionomeric membrane. As shown, a poly sulfonated polystyrene nanofiber (PSPS) matrix 2035 comprises a mesh of nanofibers comingled with a polymer comprising backbones 2001 and attached ionomers 2002. The presence of the nanofiber mesh influences the density, crystallinity, porosity, and durability of the polymer membrane.

In one embodiment made in accordance with this invention, the extruded nanofibers are gently crushed in a mechanical press to shorten their length thereby increasing film density. Such methods are required if the nanofiber mesh results in an overly porous film suffering from fuel crossover in direct methanol fuel cells (DMFCs) or excessive oxygen back streaming in hydrogen PEM fuel cells. By breaking the nanofibers into shorter snippets their impact on the intrinsic density of the polymer host material is reduced.

Other nanotechnology methods applicable to polymer ion exchange membranes include the integration of dopamine nanoparticles in PTFE matrix. Historically such technology have been used exclusively in filters for biomedical applications. Recent research on dopamine polymers has expanded into its repurposing as permanent fillers for ion exchange membranes and for hosting catalysts. Examples include Nafion® composite membranes impregnated with polydopamine and poly(sulfonated dopamine). In manufacturing, Nafion® composite membranes are doped with poly(sulfonated dopamine) (sPDA) by forcing the membrane to swelling, introducing the sPDA, then drying the film to return to its normal dimensions.

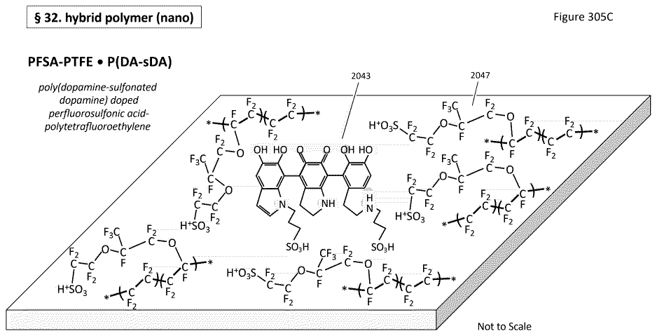

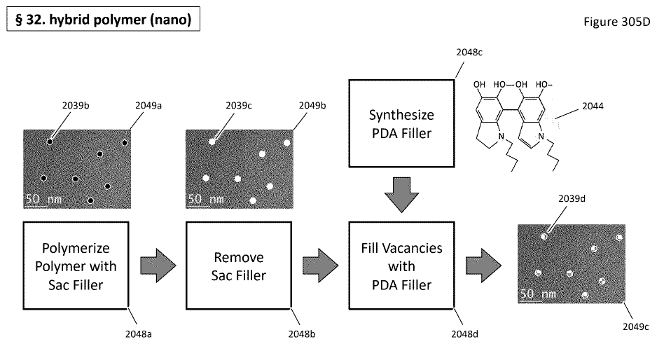

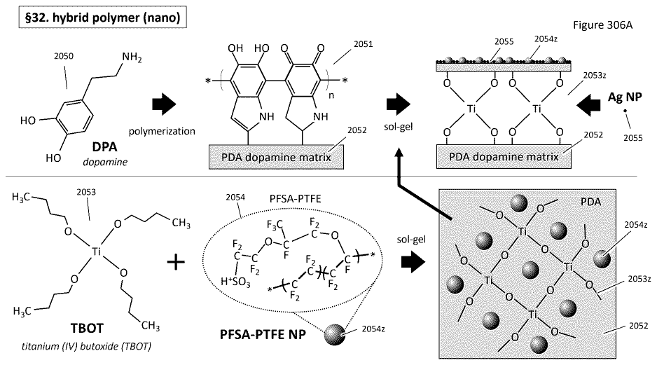

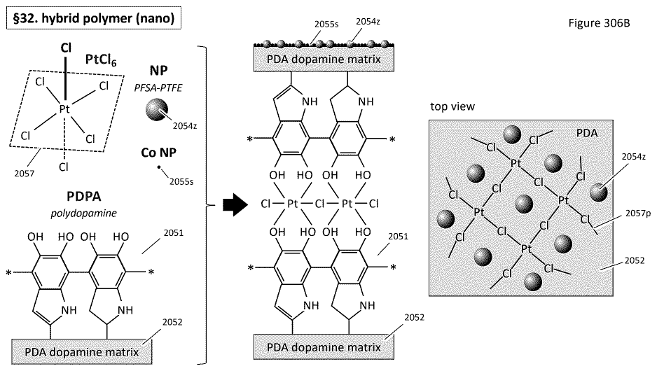

As shown in FIG. 305A the described process involves the following steps (a) in step 2045a synthesize PFSA-PTFE membrane 2046a, (b) in step 2045b the PFSA-PTFE matrix is humidified in order to create pores 2039a in membrane 2046b, (c) in step 2045c polydopamine (PDA) 2044 is independently synthesized, (d) in step 2045d PDA is injected into the swollen open pores, and (e) the membrane is dried to reduce the membrane swelling and shrinking the pores.

As shown in FIG. 305B polymerization of reactant monomers comprising either dopamine (DA) 2040, sulfonated dopamine (sDA) 2041, or a combination thereof in a mix of methanol (MeOH) and sodium hydroxide (NaOH) results in three possible chemical products—polydopamine PDA 2042, poly(sulfonated dopamine) P(sDA) 2042, and poly(sulfonated dopamine) P(DA-sDA) 2044.

A schematic representation of a membrane comprising poly(sulfonated dopamine) P(DA-sDA) 2044 doped perfluorosulfonic acid-polytetrafluoroethylene 2047 is shown in FIG. 305C. Although dopamine doping offers several theoretical advantages over pure PFSA, the conductivities of the measured films as reported was in fact lower than the undoped membranes, a deficit attributed to interfacial effects. The degradation is more readily explained by the severe swelling and subsequent drying required to create the pores.

As humidity cycling is a known failure mechanism for PFSA films, the extreme humidification required to create the dopant pores and subsequent desiccation unavoidably induces defects and membrane stresses, damaging its innate ionomers. Moreover, as PFSA pore size increases made possible through humidification are limited, the concentration of dopamine able to fit within these pores is limited. A such the beneficial impact of adding dopamine ionomer sites is more than offset by damage to PFSA polymer's ionomers. Also the method for creating pores through swelling is limited to PFSA and is not applicable for hydrocarbon based polymers.

Made in accordance with invention, the formation of pores to trap and retain dopamine in an ion exchange membrane is achieved through the disclosed process using a sacrificial filler as shown in FIG. 305D. As shown a sacrificial filler is added to monomers used to form a fluorocarbon or hydrocarbon polymer or ionomeric polymer. During molding, casting and/or polymerization shown as step 2048a the polymer 2049a such as PFSA-PTFE, PVA, PSf, TPU, PE, etc. forms around sacrificial filler 2039b intercalated within its matrix. In step 2039n entitled “Remove Sac Filler” the sacrificial filler is dissolved by a solvent which does not chemically attack the polymer itself. For example if sucrose is a the sacrificial filler co-molded in a PFSA-PTFE membrane, water can be used to remove the filler without damaging the polymer.

The remnants of the removed sac filler in membrane polymer 2049b comprise vacancies 2039c persisting in regions where the sacrificial filler once occupied. Meanwhile in step 2048c, polydopamine (PDA) 2044 is synthesized as a permanent membrane filler. In step 2048d, the PDA 2044 dopant fills the vacancies 2039d in membrane 2049c thereby increasing the conductive ionomeric pathways in the matrix. Since no extreme hydration or swelling is used to modify the polymer matrix, the membrane's intrinsic electrical and material properties remain undisturbed. Moreover the PDA doped membrane can be formed in conjunction with a endoskeletal frame to provide added mechanical support.

Polydopamine can also be used to form catalytic coatings. FIG. 306A illustrates a process for forming a sol-gel based dopamine PTFE coating with silver nanoparticles. As shown dopamine (DPA) monomer 2050 is polymerized to form a dopamine matrix 2052 composed of repeated DPA catechols 2051. In a parallel process, titanium (IV) butoxide (TBOT) 2053 is combined with PFSA-PTFE 2054 formed as ionomeric nanospheres 2054z are combined together using a sol-gel process forming a titania framework 2053z ionomeric nanospheres 2054z. This gel is then combined with dopamine matrix 2052 to form a dopamine scaffold comprising titania framework 2053z, dopamine substrates 2052, and coated with silver nanoparticles (Ag NPs) 2055 and additional PFSA-PTFE NPs 1054z. In one implementation a sol-gel based process comprising silver nanoparticles and polytetrafluorethylene (AgNP/PTFE) forms a coating with enhanced antibacterial and anti-corrosive properties. Such a coating is not useful in electrochemical applications such as a fuel cell or electrolyzer.

Made in accordance with this invention, a nanocoating applicable to fuel cells shown in FIG. 306B comprises polydopamine matrix 2052 with repeating catechol 2051 units combined with platinum (IV) chloride PtCl₆ 2037, PFSA-PTFE nanoparticles 2054z, and scavenger metal nanoparticle 2055s such as cobalt (Co), nickel (Ni), or iron (Fe). A Co NP is shown. Platinum chloride PtCl₆ 2037 as shown include four in-plane chlorines and two Cl forming platinum bonds perpendicular to the bonding plane, one above, one below. These components combine to make a stereo isomeric sandwich containing parallel matrix planes bound by inward facing catechols 2051. The OH groups replaces the upper and lower chlorines completing the dopamine bonds to the platinum center. Within the platinum plane, lateral Pt-to-Pt bonds occurs through Cl intermediaries, not oxygen or hydroxide. A top view illustrates the chlorine-platinum framework 2057p sequestering PFSA-PTFE nanoparticles 2054z sandwiched within PDA matrix 2052. The surface of PDA matrix 2052 as shown is coated by cobalt nanoparticles (Co NP) 2055s and additional PFSA-PTFE nanoparticles 2054z.

Coated atop an ion exchange membrane the film provides hydrogen catalysis through its platinum core, commences proton hopping conduction of ionized hydrogen (H⁺) by sulfonic ionomer groups located within the PFSA-PTFE nanoparticles 2054z, and inhibits carbon monoxide poisoning of the platinum catalysts by the surface layer of cobalt nanoparticles 2055s or other scavenger metal NPs. In this manner, the inventive coating increases fuel catalysis and improves membrane conductivity while simultaneously protecting the catalyst from CO poisoning.

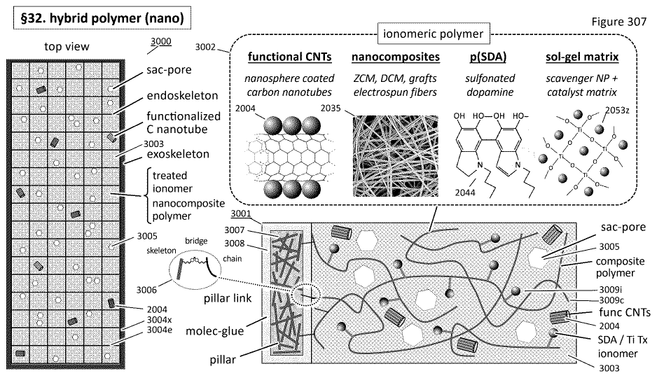

In summary, membrane top view 3000 and membrane side view 3001 in FIG. 307 illustrate a variety of elements of ionomeric polymer 3002 with nanoparticle doping, fillers, and coatings made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating is formed atop membrane 3003 to either enhance membrane conductivity, increase the rate of oxygen reduction reactions (ORR) in the cathode, provide protection against membrane poisoning, or a combination thereof including boron nitride or other materials that inhibit the diffusion of carbon monoxide (CO) into the catalyst layer;
where ionomeric polymer 3002 may comprise a fluorocarbon such as PFSA, extended ePTFE 1071a, PFSA-PTFE 1958, dopamine composite membranes 1971b, polyimide coated PFSA-PTFE 1955, nanocomposite membrane 1960, sulfophthalic-acid-polyvinyl-alcohol (SPA-PVA) 2010, polyvinyl alcohol-polyethylene-oxide (PVA-PEO) 2013 and copolymers thereof, sulfophthalic acid polymer (SO₃H-PSPA) 2010a, poly(sulfonated dopamine) aka P(SDA) 2044, copolymers of sulfonated polyvinyl alcohol-co-sulfophthalic acid-co-polyethylene oxide (s(PVA-co-SPA-co-PEO)) 2015, radiation induced grafted polymers 2029, and optionally polymers blended with other homopolymers, heteropolymers, copolymers, thereby controlling varying degrees of film crystallinity and anisotropy to form a hybrid copolymer;
where ionomeric polymer 3002 may comprise pendants such as phosphorated titania 2014 of formulation PO₄TiO₂ or similar, or may include sol-gels integrating titanium, silver, platinum, or palladium nanoparticles 2053z collectively influencing crystalline regularity, porosity, conductivity, and fuel crossover of the membrane;
where ionomeric polymer 3002 may comprise copolymers linked by organic ligands such as glutaraldehyde (GA) 2011 and 4-sulfophthalic acid (SPA) 2012;
where PDA fillers may be injected into vacancies of a polymer comprising pores created by swelling or using sacrificial filler process described herein;
where ionomeric polymer 3002 may comprise an ionomer 3009i of reactive sulfonic acid R group —SO₃H, SO₃Na, sulfobutyl groups, and/or phosphorated titania (PO₄TiO₂) 2014;
where ionomeric polymer 3002 may include embedded ionic fillers such as CeO₂ and ZrO₂ nanocomposites 1964, polybenzimidazole (PBI) and pyridine polybenzimidazole (PyPBI) functionalized nanoparticles 1983, amino-functionalized nanoparticles 1985, platinum coated nanotubes 1987a, titanium coated nanotubes 1987b, platinum-chloride coated carbon nanotubes 1991, platinum-tin coated nanotubes 1989c, nanosphere-coated carbon nanotubes 1992; electrospun sulfonated polystyrene nanofibers and mats 2035; sulfonated and un-sulfonated polydopamine fillers (PDA, sPDA, and PDA-sPDA)
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte;
and finally where the combination of the endoskeletal pillars and the membrane coating are used to seal in any ionic liquid doping to prevent seepage, leakage, or IL depletion.

Nano-treated hybrid polymer IEMs include nanolayers, nanofibers, nanocoatings, nanoparticles, nanoclusters, nanospheres, nanotubes, nanocomposites, and nanoparticle coated carbon nanotubes. Aside from nano treated membranes, novel nano polymers include dopamine membranes (PDA, P(sDA), P(DA-sDA)); hybrid nano-doped polymers such as {PFSA-PTFE•P(DA-sDA)}; nano-coated membranes (DCM, ZCM, PtCM); phosphorylated titania-carbon-nanotube (PO₄TiO₂ CNT) doped sulfonated polyvinyl alcohol-co-sulfophthalic acid-co-polyethylene oxide (s(PVA-co-SPA-co-PEO)); radiation-grafted polymers, and sulfonated polystyrene (P(sPS) NF) nanofiber infused membranes. The following table describes the construction of various nano-treated polymers:

| ionomer | structure | endoskeleton | solvents, X-L | fillers |
|---|---|---|---|---|
| §32A. nano treated | hybrid polymer | polymer: | solv: catalysts, | nano fillers: nano |
| polymers | nano treated IEM | matched to | used in forming | coatings, ZCM, |
| PFSA-PTFE, PFIA | nanolayers | IEM polymer. | polymers match | PtCM, NP coated |
| PFSA-PVA-PTFE, SPA-PVA | nanofibers | pillar: | membrane, not | CNTs (Pt—NH2, |
| SPAES, sPEEK, sPEES | nanocoatings | reinforcing | filler | Ti—NH2, PO₄TiO₂ NP, |
| sPVA, sPBI, sCS | nanoparticles | fillers (C-fiber, | X-L: reagents | Pt—Sn, rad graft, |
| §32B. novel nano polymer | nanoclusters | CNTs) | matching | nano fiber (sPS), |
| PDA, P(sDA) | nanospheres | | membrane | SPDA NP, P(DA- |
| P(DA-sDA) | nanotubes | | polymer | SDA) NP |
| PFSA-PTFE•P(DA-sDA) | nanocomposite | | | other fillers: |
| DCM, ZCM, PtCM | | | | sac filler, oxides, |
| s(PVA-co-SPA-co-PEO) | | | | POSS, MOFs, PIL |
| radiation grafted IEM | | | | |
| P(sPS) NF infused IEM | | | | |

Endoskeletal support is matched to the membrane chemistry as is applicable solvents, polymerizing agents, catalysts, and cross linkers. Nano fillers described herein include nano coatings, composite coated membrane (DCM, ZCM, PtCM); nanoparticle coated CNTs (Pt—NH₂, Ti—NH₂, PO₄TiO₂ NP, Pt—Sn); radiation grafted polymers; nanofibers of sPS; dopamine nanoparticles (PDA, sPDA, P(DA-sDA)). Aside from nano fillers, membrane fillers and dopants described previously have been omitted for the sake of brevity, and will not be repeated here.

### § 33. Functionalized Hybrid Zirconium-Doped Polymer IEMs.

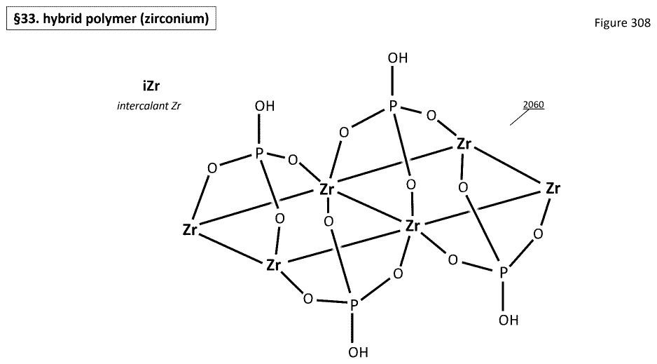

The element zirconium is a ductile metal highly resistant to corrosion and heat. Applications include its use in ceramics, lamp filaments, catalytic converters, nuclear reactors, furnace bricks, and other high temperature environments. Zirconium and its compounds such as zirconium phosphate can also function as an inorganic ion exchanger and solid state proton conductor making it attractive for use in batteries and in fuel cells. FIG. 308 illustrates the structure of a zirconium phosphate comprising a phosphorus-oxygen matrix with intercalated zirconium atoms, the combination providing the electrical activity of a metal but the structural support of an oxide.

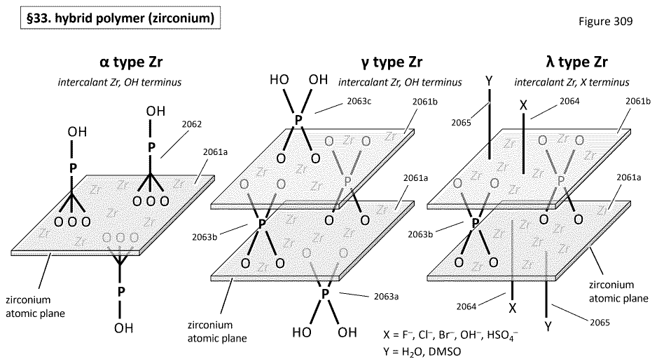

As depicted in FIG. 309 illustrates layered zirconium phosphates and phosphonates prospectively useful as nanofillers for ionomeric membranes. The zirconium phosphate atomic strata are represented as three main types of layered 3D structures—α type, γ type, and λ type zirconium. In α-type zirconium phosphate, intercalant zirconium exists as a single sheet of Zr atoms 2061a bonded by tri-dentate mono-hydrogen phosphate groups, located alternatively nearly perpendicularly 2062 above and below the plane terminating in an OH group. The chemical formula for α-type zirconium is (Zr(O₃POH)₂·H₂O). Structurally, the octagonally arranged zirconium atoms creates minute six-sided cavities containing the crystallization water molecules.

By contrast γ type zirconium phosphate Zr(PO₄)(O₂P(OH)₂)·2H₂O, zirconium atoms are arranged in parallel planes 2061a and 2061b bound to other planes by PO₄³⁻ tetrahedra 2063a, 2063b, and 2063c via unprotonated oxygen, but ultimately terminating with hydroxide atoms. In λ type zirconium, exposed phosphate groups are replaced by monovalent anions X 2964 and a neutral ligand Y 2076 represented by the general formula Zr(PO₄)XY, where X={F⁻, Cl⁻, Br⁻, OH⁻, HSO₄⁻} and Y={DMSO, H₂O}.

Although the tri-dentate phosphate groups 2062 in α-type zirconium phosphate are better suited for proton conduction or ion separation filtering than its other configurations, ion exchange membranes comprising layered zirconium phosphate perform unremarkably compared to other ionomeric polymers. Instead composite membranes doped with nanosized zirconium phosphate, phosphonates or organophosphates offer a higher potential than bulk zirconium phosphate. The Zr nanoparticles can be used as ionomeric fillers in a variety of membrane types including PFSA, PFSA-PTFE, polyether sulfone (PESf), and others.

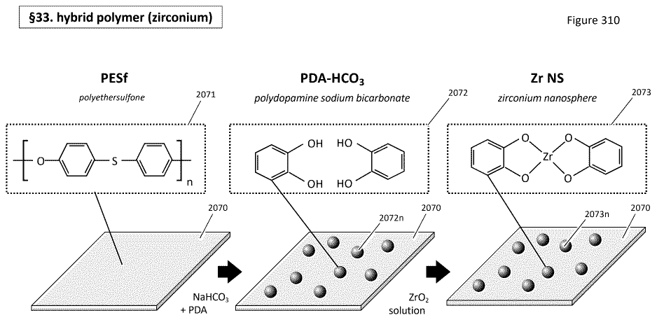

For example FIG. 310 illustrates a process for forming a zirconia layer coated polyether sulfone substrate for example forming high flux membranes based on in-situ formation of zirconia layer coated the polyether sulfone substrate. Beneficial for ionic separation applications, a polymeric membrane 2071 comprises polysulfone (PESf) 2071 treated by sodium bicarbonate (NaHCO₃) and polydopamine (PDA) forming nanospheres 2072n of polydopamine sodium bicarbonate (PDA-HCO₃) 2072. Subsequent immersion in a solution of ZrO₂ decorates the nanosphere surfaces with zirconium 2073 functionalizing the Zr NS 2073n into an ionomer.

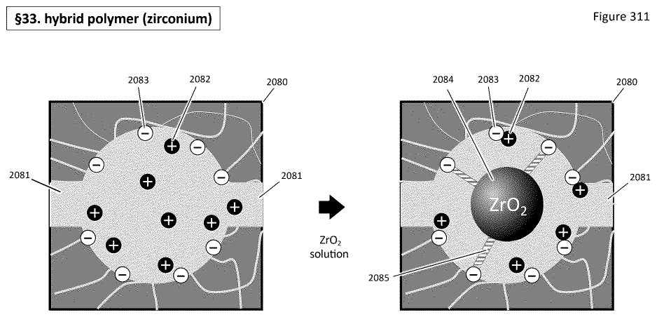

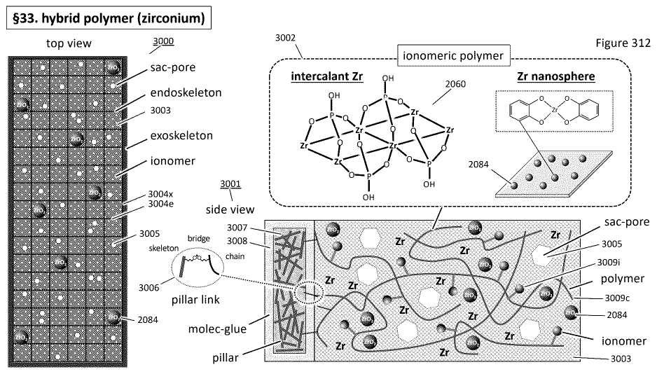

For example, the in situ formation of ZrO₂ nanoparticles within the pores of an ion exchange membrane can modulate water uptake, i.e. either increase or decrease hydration, as well as improve selectivity and conductivity. The bonding mechanisms for a Zr NP within a IEM pore and the resulting impact on ion concentrations and pH is depicted graphically FIG. 311. By introducing inorganic oxide nanoparticles into an ion-exchange membrane, the acid-base properties of the electrolyte can by adjusted modulating its conductivity and permselectivity.

As shown, a conduction channel 2081 in membrane 2080 contains a number of free protons 2082 and electrons 2083 that varies with pH of the solute. The addition of a ZrO₂ nanoparticle NP 2084 in the pore electrostatically bonds 2085 to the interior sidewall. The catalytic action of the NP buffers the acid base reactions facilitating neutralization of excess protons 2082 by electrons 2083 reducing the impact of pH variations on IEM conduction. Such electrochemical auto-regulatory mechanisms are especially valuable in ionomeric membranes used in electrodialysis, electro-deionization, and diffusion dialysis.

Although zirconium can beneficially affect the performance of a ion exchange membrane, it cannot control porosity or pore density nor improve film durability. When combined with other features made in accordance with this invention such as the use of a sacrificial filler to form vacancies to capture and hold the Zr nanoparticles or the addition of an endoskeleton to provide mechanical support to the membrane, the potential benefit of zirconium in IEM function is greatly enhanced.

In summary, membrane top view 3000 and membrane side view 3001 in FIG. 312 illustrate a variety of elements of ionomeric polymer 3002 containing zirconium phosphate or zirconium nanoparticles made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 comprises any fluorocarbon or hydrocarbon based membrane containing zirconium including intercalant Zr 2060 present throughout the polymer lattice including α-type Zr 2061a with phosphorylated pendants and OH terminus, γ-type Zr 2061b with phosphorylated pendants and O terminus, and λ-type Zr 2061c with phosphorylated pendants and radical X terminus 2064 comprising F⁻, Cl⁻, Br⁻, OH⁻, HSO₄⁻ and with secondary pendants 2065 terminating in H₂O or dimethyl sulfoxide (DMSO). where the Zr doped membrane may optionally blended with other homopolymers, heteropolymers, copolymers, thereby controlling varying degrees of film crystallinity and anisotropy to form a hybrid copolymer;
where ionomeric polymer 3002 may comprise multi-acid sidechain 1803 serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include embedded ionic fillers including zirconium nanospheres 2084;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group; and finally
where the combination of the endoskeletal pillars and the membrane coating are used to seal in any ionic liquid doping to prevent seepage, leakage, or IL depletion.

Features of a zirconium doped polymer for filtration or as an ion exchange membrane are described in the following table including a description of various ionomers, as well as applicable endoskeleton constructions, solvents and reagents used in its fabrication, cross linking molecules used to induce polymerization as well as to promote bonding between the polymer the endoskeletal pillars. The table also lists a variety of fillers which can be added to improve performance and film durability.

| ionomer | structure | endoskeleton | solvents, X-L | fillers |
|---|---|---|---|---|
| 33. Zr-doped polymers | Zr doped | polymer: | solv: catalysts, | Zr fillers: |
| PFSA-PTFE, PFIA | hybrid polymer | matched to IEM | used in forming | (Zr(O₃POH)₂ |
| PFSA-PVA-PTFE, SPA-PVA | | polymer. | polymers match | Zr(PO₄)XY, ZrO₂ |
| SPAES, sPEEK, sPEES | | pillar: reinforcing | membrane, not | NPs |
| sPVA, sPBI, sCS | | fillers (C-fiber, | filler | other fillers: |
| | | CNTs) | X-L: reagents | sac filler, CNTs, |
| | | | match | oxides, POSS, |
| | | | membrane | NPs, MOFs, PIL |
| | | | polymer | |

Zirconium doping made in accordance with this invention can be added to any type of membrane, wither by coating the membrane of by infusing the polymer with ZrO2 nanoparticles. In one embodiment, the Zr NPs residing within the membrane are contained within vacancies created in the matrix using the described sacrificial filler process. Endoskeletal support is matched to the membrane chemistry as is applicable solvents, polymerizing agents, catalysts, and cross linkers. Zirconium fillers described herein, membrane fillers and dopants described previously have been omitted for the sake of brevity, and will not be repeated here.

### § 34. Functionalized Hybrid Metal Oxide Framework (MOF) Doped Polymer IEMs.

Metal oxide frameworks represent a new class of membrane dopants combining organic and metallic components. In a MOF a matrix of metal atoms are interlinked into a framework by organic ligands. A MOF is the metallic version of a covalent organic framework (COF). COFs are a class of materials forming porous quasi crystalline structures connected by strong covalent bonds. Because they lack metal atoms however COFs cannot provide the same degree of catalytic activity or conductivity boosts that metal atom offer.

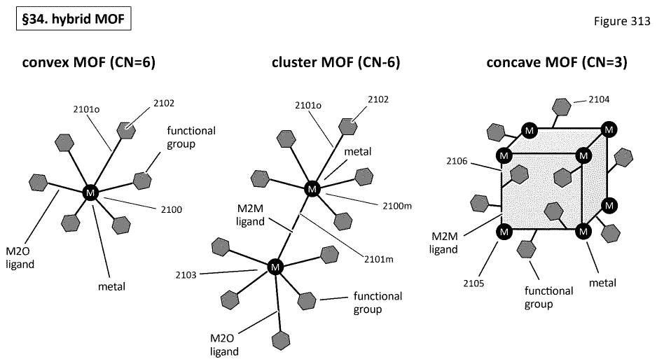

The behavior of a MOF depend not only on its composition but on its crystalline structure. FIG. 313 categorizes metal oxide frameworks (MOFs) into three classes—convex star or sunburst patterns, MOF clusters, and concave or closed MOF geometries. Sunburst or star MOFs include a central metal atom 2100 serving as a catalyst or ionomer surrounded by organic ligands 2101o terminating in functional groups 2102.

The ligands bond to the metal core and can therefore are referred to as metal-to-organic ligands labelled by the homophonic acronym M2O. Convex MOF topologies increase the ratio of functional groups to metal ions thereby reducing the relative electrochemical contribution of metal within the MOF in favor of more functional groups. For example one catalyst metal ion can break a molecule into multiple pieces, where the functional groups chemically process the resulting pieces.

The coordination number or CN defines the number of ligands bonded to a metal atom regardless if whether the terminus of the organic ligand is a functional group or another metal atom. In the example shown CN=6 means six organic ligands 2101o are bonded to central metal atom 2100. In this manner the CN represents the degree of connectivity of the metal atoms in the frame. By example a CN=8 metal atom has a greater number of attached organic ligands than a CN=6 MOF topology. While in the case of a convex MOF a higher CN means ratiometrically more functional groups than metal ions, in a concave MOF comprising closed geometric figures such as cubes and trapezoids, a larger CN number indicated a greater degree of metal-to-metal scaffolding and mechanical strength and/or rigidity. Note the term CN is an acronym for coordination number and should not be confused with the abbreviation for toxic chemical cyanide.

Another example is the cluster MOF comprising two or more atoms bonded to functional groups 2102 by metal-to-organic M2P ligands 2101o but where the metal atoms are bond by metal-to-metal, i.e. M2M, ligands 2101m. The metal to metal bonds add additional structure and strength to the MOF without sacrificing the density of functional termini. A concave MOF as shown primarily comprises immobile metal atoms arranged in a fixed geometric pattern by a special M2M ligand 2106 able to attach to functional groups 2104, where in most cases the functional groups do not bond to the metal ions through a dedicated M2O ligand. In such cases the metallic framework is strengthened but with reduced electrochemical activity of the functional groups. In some cases the purpose of the functional groups is to capture and sequester foreign molecules including toxins, salts, or gasses. Applications of MOFs thereby may possibly include water filtration, blood electrodialysis, hydrogen capture and storage, desalinization, and even capture of radioactive elements such as uranium or radioactive cesium.

As illustrated some of the functional groups may located inside the geometric structure, hence the term concave MOF, while other groups may exist outside the frame like a convex MOF. In many applications such as molecular sequestering the exterior functional groups are not strong enough to indefinitely hold guest atoms and ions. Conversely, for the concentric facing functional groups, the retention of MOF guests is supported by the added framework of the M2M ligands 2106 that act as prison bars preventing accidental escape of sequestered visitor molecules. Pressure and temperature affect equilibrium ratio of captured and free molecules as well as the size and electrostatic surface potential of captured ions.

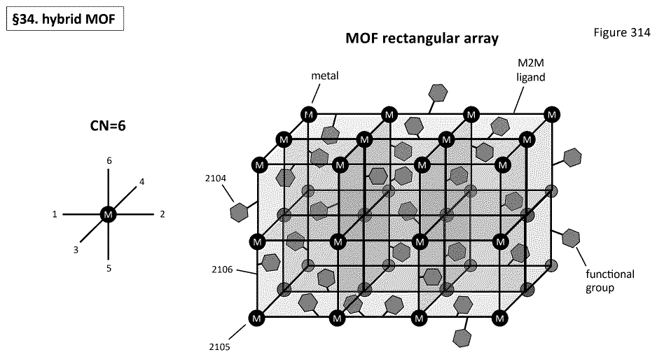

The volumetric capacity of a regular geometrically shaped MOFs can be extended into three-dimensions as exemplified in FIG. 314. In such a case the coordination number of 3D rectangular grid becomes CN=6 where, ignoring the edge atoms, each metal atom neighbors four atoms in its plane plus has another neighbor above and below it. Importantly as the dimensions of the array scale the ratio of internal functional groups compared to the exterior facing groups grows as is evidenced in the illustration. Many of the man-made MOF geometries can fill space in three dimensions by mimicking natural crystals, potentially thereby including cubic, face centered cubic, hexagonal, tetragonal, orthorhombic, trigonal/tetrahedral, double tetrahedral, monoclinic, triclinic, and dodecahedral.

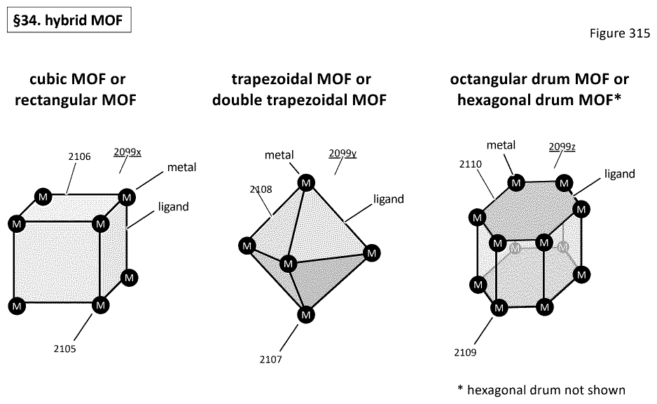

FIG. 315 illustrates various geometric configurations of metal organic frameworks (MOFs) including cubic 2105, reflected trapezoid 2107, and octahedral drum 2109 topologies. A hexagonal drum is not shown but can generated by modifying an octagonal shaped metal-ligand ring into a hexagonal one.

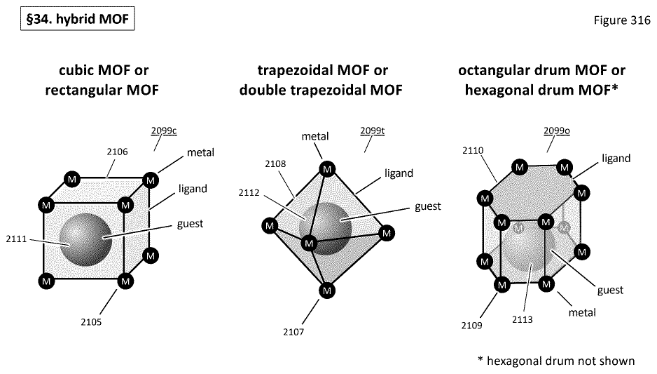

FIG. 316 illustrates various geometric configurations of metal organic frameworks (MOFs) hosting guest molecules including cubic 2106 with guest 2111, reflected trapezoid 2108 with guest 2112, and octahedral drum 2110 with guest 2113, or hexagonal drum (not shown). If the guest atom is captured not during use, but during fabrication, the guest may be a permanent element of the MOF, potentially functioning as a catalyst or ionomeric element independent of an organic functional groups (not shown).

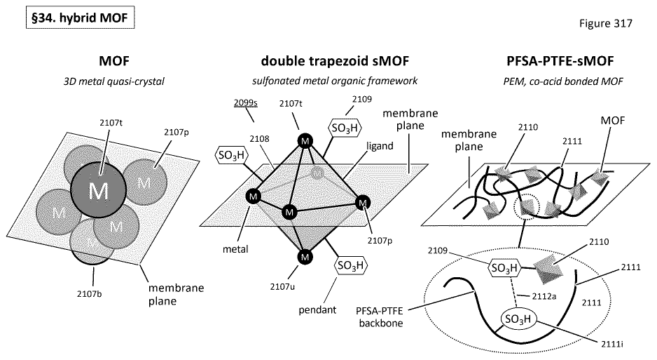

FIG. 317 illustrates elements of MOFs at various magnification factors. At the highest resolution, metal ions appear as a quasi 3D stack of metal atoms represented as atoms 2107p in the plane of a membrane, metal atoms 2107t located atop the plane, and metal atoms 2107b located beneath the plane. At a lower magnification, a double trapezoidal MOF 2099s comprises a trapezoid above the atomic plane of metal atoms 2017p as delineated by atom 2107t forming a second reflected trapezoid below the atomic plane ad delineated by metal atoms 2017b. The organic ligands 2018 as shown functionalized by HO₃S sulfonic acid as an exemplary ionomer 2109. The incorporation of the MOF quasi crystal 2110 into a PFSA-PTFE 2111 composite reinforced membrane (CRM) is illustrated in the rightmost depiction entitled PFSA. As depicted in the inset, bonding of a MOS quasi-crystal 2110 to a PFSA-PTFE 2111 mainchain may occur through a homogenous sulfonic-to-sulfonic acid bond 2112a.

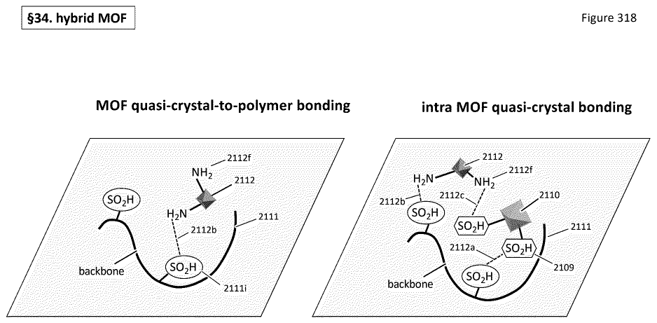

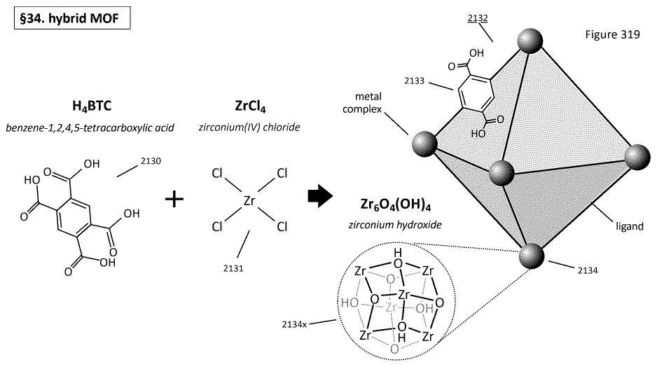

As shown in the left side drawing of FIG. 318, heterogenous 2112b bonding may occur between a MOF-attached functional group such as NH₂ 2112f and the immobile ionomer 2111i bound to a polymeric backbone 2111. In addition to homogenous and heterogenous bonding betwixt a polymer's mainchain and a membrane's MOF doping, heterogenous bonding can also occur from one MOF quasi-crystal to another. For example, heterogenous bond 2112c between SO₃H ionomer 2019 and the NH₂ functional group 2112f securing bonds MOF quasi-crystals 2110 and 2112 together while the heterogenous bond 211b and homogenous bond 2112a secure the two interconnected MOF quasi crystals 2110 and 2112 firmly in place.

Although the 2112a, 2112b, and 2112c bonds comprise Van der Waals or hydrogen bonds, secured by the expansive spiderweb like network of PFA-PTFE 2111 polymer fibers, the MOF quasi crystals are non-subject to dislocation within the matrix. It should be noted that bonding within the MOF is covalent bonding through organic ligands while crystal-to-crystal bonds are not as strong, being electrostatic in nature. Through its functional groups MOFs can enhance electrochemical activity, catalysis, ionic selectivity, or conductivity of a membrane.

FIG. 319 illustrates the metal corners 2134 of MOF 2132 need not be limited to elemental metal atoms but may comprise metal complexes 2134x such as Zr₆O₄(OH)₄. Such a complex can be derived from zirconium(IV) chloride 2131. When combined with benzene-1,2,4,5-tetracarboxylic acid (H₄BTC) 2130, the fabricated MOF 2132 includes ligands containing aromatic rings 2133 such as phenol or benzene. Exemplary applications of MOF 2132 in ultrathin MOF based membranes for chemical separation may comprise an ultrathin metal-organic frameworks membranes for high-performance separation but may be modified for ionomeric functions.

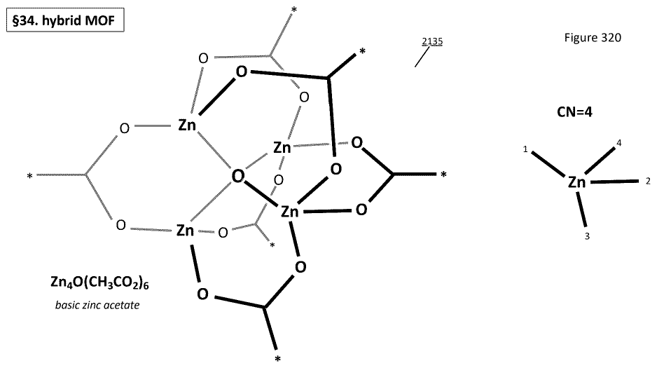

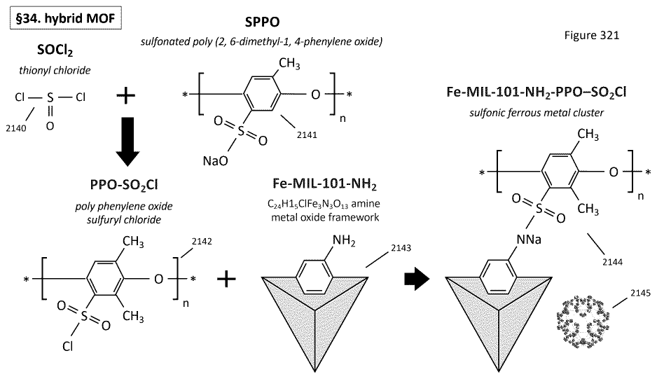

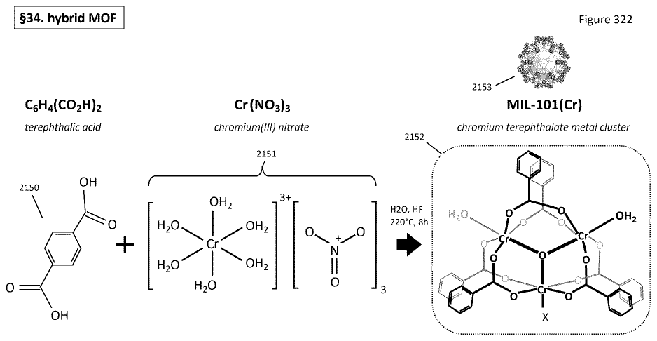

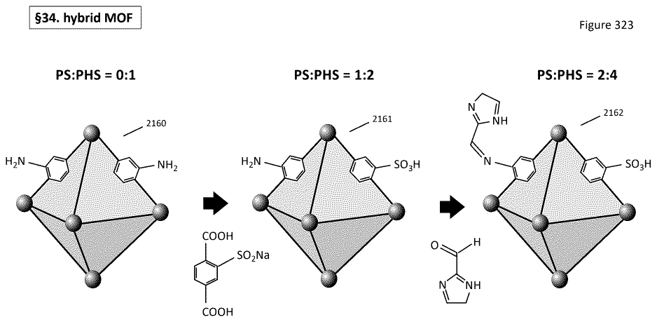

Metal complexes may be formed by any number of transition metals including basic zinc acetate 2135 with formula Zn₄O(CH₃CO₂)₆ and with coordination number CN=4 shown in FIG. 320 as described by Wikipedia under the topic “Metal-organic framework”. Other metal clusters may comprise iron, symbol Fe, as shown in the process flow of FIG. 321 combining thionyl chloride (SOCl₂) 2140 and sulfonated poly (2, 6-dimethyl-1, 4-phenylene oxide) monomer (SPPO) 2141 to form poly (phenylene oxide sulfuryl chloride) (PPO-SO₂Cl) 2142. The polymer PPO-SO₂Cl is then reacted with the metal organic framework C₂₄H₁₅ClFe₃N₃O₁₃ amine (Fe-MIL-101-NH₂) to form sulfonic ferrous metal cluster 2145 chemically identified phenylated polymer 2144 having the formula Fe-MIL-101-NH2-PPO—SO₂Cl. Exemplary processes include a sulfonic ferrous metal cluster forming a metal organic framework beneficial for enhancing ionomer conductivity. Metal clusters may also be formed of chromium as shown in the exemplary process of FIG. 322 where chromium (III) nitrate 2151 chemically as Cr(NO₃)₃ is reacted with terephthalic acid 2150 aka C₆H₄(CO₂H)₂ to form chromium terephthalate MIL-101(Cr) 2151 to form metal cluster 2153.

A key component of any MOF is the organic ligand used for metal-to-metal bonding. Material selection and processing determines the relative ratio of proton sites (PS) to proton hopping sites (PHS). As depicted in FIG. 323, the PS:PHS ratio can be affected by processing where amino linked MOF 2160 is nearly an insulator as with PS=0 and PHS=1 it can neither source protons nor effectively transfer them. Treatment by a sulfonic acid, some of the NH₂ ligands are converted to SO₃H thereby improving the conductivity parameters to S:PHS=1:2. Subsequent treated by hydroxy pyrrole further enhances ionic activity boosting performance to S:PHS=2:4.

Although reactivity of an MOF can be enhanced, highly reactive metal atoms or metal clusters functioning as catalysts or ionomers become increasingly put at risk for poisoning from carbon monoxide and other toxins proportion to electrochemical activity. Aside from carbon monoxide, other compounds poison to metallic catalysts such as Pt and Pd include halides, cyanides, sulfides, sulfites, phosphates, phosphites, and organic molecules such as nitriles, nitro compounds, oximes, and nitrogen-containing heterocycles. Poisoning generally involves a toxin bonding to active sites of a catalyst, reducing the catalytic density and increasing the mean free path required for reactants to reach a catalyst.

If the poisoning occurs slowly the catalyst layer coating a PEM membrane will become dysfunctional in a unform homogenous manner. Conversely, if the reaction occurs rapidly damage will concentrate near the gas inlet impeding gas flow by an inactive shell, a condition known as pore-mouth poisoning. To prevent poisoning three inventive solutions are proposed (a) remove toxins by a chemical scrubber at the gas ingress, (b) employ scavenger metals to capture and sequester toxic gasses from reaching the catalyst metal, or (c) restoring damaged catalysts by detoxifying the active site of the metal.

Although metal organic frameworks may play a role in all three solutions, an inventive MOF design can be especially beneficial in case (b), reducing the statistical probability of a toxin reaching the catalyst sites by chemical gettering. Specifically by imposing scavenger metals along the path of gas flow, i.e. metals not involved catalysis or conduction, the likelihood that a toxin can ever reach active metal sites is diminished. The scavenger metal laced MOFs can be present within the polymeric membrane, within the catalyst layer, or coated atop the catalyst layer.

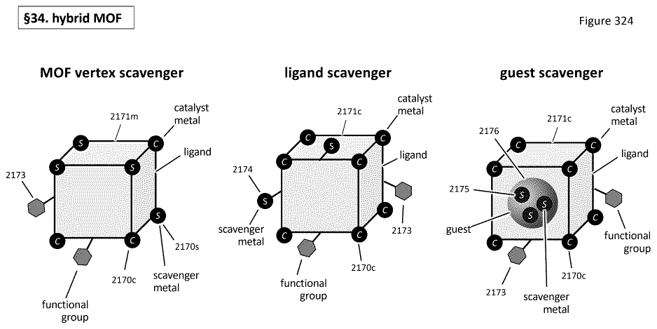

In one embodiment of a scavenger MOF, a metal oxide framework contains two types of transition metals, one serving as the catalyst or ionomer, the other functioning as a scavenger. Made in accordance with this invention, FIG. 324 described three classes of positioning scavenger metals within the framework, namely MOF scavengers, ligand scavengers, and guest scavengers. In the case of MOF scavengers, the corners of the framework are alternatively shared between active catalyst metals 2170c, and scavenger metals 2170s. To perform bonding between mixed metal types, a special organic ligand 2171m is required able to bond to both elemental metals. In this example, functional group 2173 does not participate in either catalytic or ionic conduction mechanisms within the MOF.

By contrast, the ligand scavenger shown in the center illustration comprises a homogenous MOF with catalyst metals 2170c and conventional M2M organic ligands 2171c. Instead, the functional groups bound to ligands 2171c are replaced with scavenger metals 2174 or organo-metallic complexes. In a third embodiment depicted on the right side of the drawing, a convention metal oxide framework with homogenous metal catalysts 2170c, conventional M2M organic ligands 2171c and organic functional groups 2173 contains guest molecule 2175 containing scavenger metals designed to lure toxins away from the corner catalyst metal atoms 2170c.

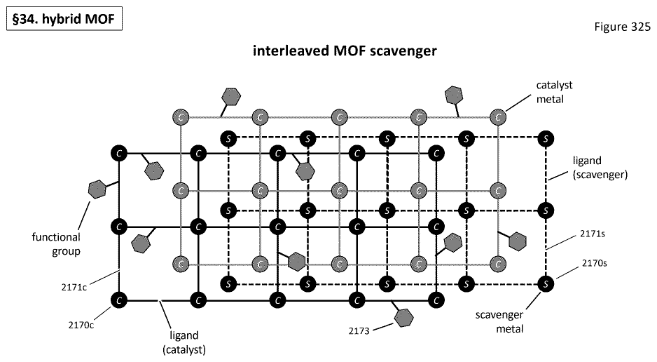

Scavenger-catalyst MOFs can be extended into multi-planar matrices. As shown in FIG. 325, the matrix comprises alternating planes comprising catalyst metals 2170c with homogenous M2M organic ligands 2171c and an alternative plane comprising scavenger metals 2170cs bound together by homogenous M2M organic ligands 2171s that may differ from ligands the catalyst M2M ligands 2171c. In one embodiment, alternating planes of catalyst and scavenger metal frames are offset by half the cubic unit dimension either in two or three axis forming an interleaved MOF. As depicted, functional groups 2173 are attached only to the catalyst frame and not the scavenger frame, but alternatively they may be attached to every planes.

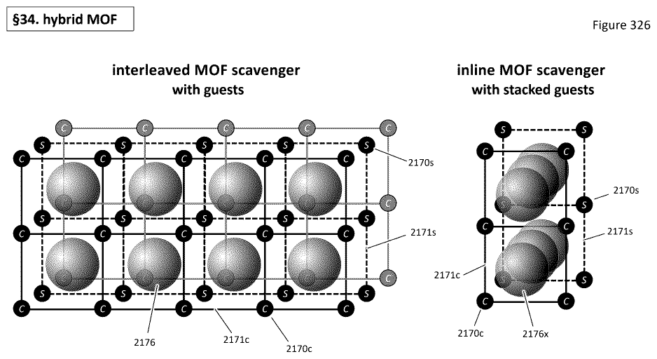

FIG. 326 illustrates three-dimensional construction of the aforementioned interleaved catalyst-scavenger framework but including guest molecules 2176. Alternatively an inline cubic framework may include a stack of guests 2176x.

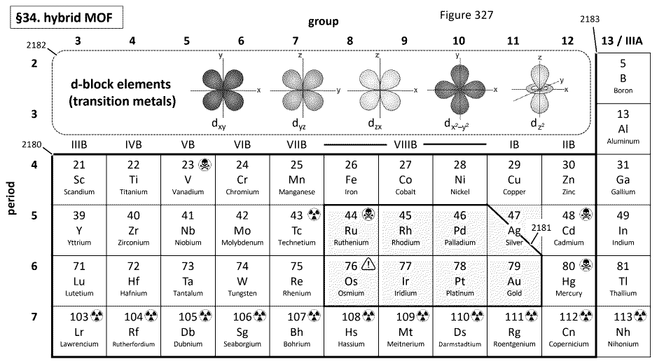

A key design consideration for the inventive catalyst-scavenger framework is the M2M organic ligands needed to bond the scavenger metals to the catalyst metal. To determine the organic ligands used for realizing such a heterogenous metal framework, the specific metals must be considered. FIG. 327 illustrates an excerpt of the periodic table of elements identifying the transition metals in groups 3 through 12 occupying the block of elements 2180. Alternatively using the shell model of the periodic table groups IIB through VIIIB correspond to groups 4-10, followed by a transition to the next atomic shell in groups 10 and 11 identified as groups IB and IIB. For reference the boron family shown in the column 13 of IIA contains semi-metal boron and metals aluminum (AI), gallium (Ga), indium (In), and thallium (TI). Although considered metals, these elements are not considered transition metals because they are not part of the D-bock elements that exhibit the d-type flower petal chemical bonds 2182. For clarity sake, line 2183 separates the transition metals from the boron group metals.

Each element on the table is identified by its atomic number, its chemical symbol, and its elemental name and highlighting dangerous, toxic, and radioactive elements consistent with RoHS government standards and symbols. The table is also arranged in rows representing the period of element. Transition metals are limited to the periods 4 through 7 of which all period 7 elements, i.e. from atomic numbers 103 to 113, along with the specific period 6 elements technetium Tc and ruthenium Ru having atomic numbers 43 and 44. Depending on its form osmium Os, atomic number 76, can be a severe respiratory irritant and in other cases a deadly toxin. It may however be used safely as in certain alloy forms.

Other transition metals excluded by RoHS standards for toxicity include vanadium V, cadmium Cd, and mercury Hg, atomic numbers 23, 48, and 80. Aside from these elements excluded for use in the their pure form, the remaining transition metals in block 2180 may be used in MOFs. Specifically the metals contained within subblock 2181, the PGM platinum group metals aka the noble precious metals, are especially useful as catalysts and ionomers in ion exchange membranes. They include rhodium Rh, palladium Pd, iridium Ir, platinum Pt and gold Au. Silver is often not considered a noble metal as it cab easily be oxidized.

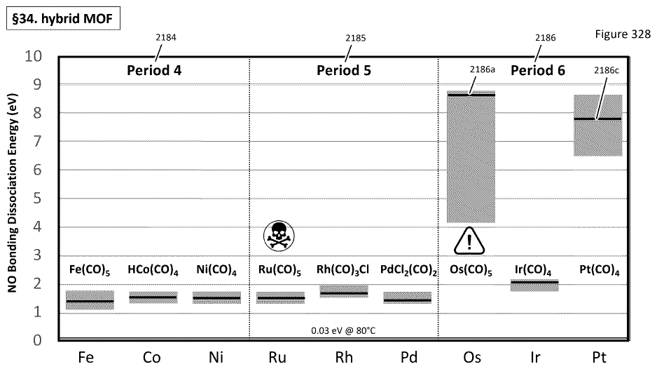

FIG. 328 identifies candidate metals for MOFs by identifying the bonding dissociation energy for the metal sequestering carbon monoxide (CO) a common ionomer and catalyst membrane ranging from 1.5 to 8.6 eV. An electron volt (eV) is a measure of energy equal to 1.602176634×10⁻¹⁹J in SI units. Of the metals shown, all identified metals bond with CO at an energy far above the 0.03 eV thermal energy kT/q at 80° C. where k is Boltzmann's constant. The fact that period 6 elements 2186 comprising Os(CO)sand Pt(CO)4 bond with the highest energies 2186a and 2186c doesn't mean that they are able to capture CO more effectively, just that once poisoned it is harder to dissociate the carbon monoxide. As shown, the best candidate for catalysts are the period 6 elements platinum (Pt) and iridium (Ir) for catalysis in hydrogen fuel cells. Iridium (Ir) is especially promising as an anodic catalyst beneficial in hydrogen electrolytic generation.

In methanol fuel cells, however, pure platinum is ineffective because of its inability to absorb water and oxidize away water. Instead in methanol fuel cells, a platinum-ruthenium allow is preferred as they bind the oxygen present in water where Rh is a period 5 metal. Other studies have considered an alloy of quaternary alloy containing platinum, ruthenium, osmium, and iridium, showing improved oxygen generation in direct methanol fuel cells. In accordance with this invention, good candidates for scavenger metals include the period 4 metals iron, cobalt, and nickel and possibly ruthenium in period 5.

The selection of bimetallic ligands able to bond dissimilar metals, i.e. a metal-ligand-hetero metal, is a key element of realizing the catalyst-scavenger MOF made in accordance with this invention. The previously unreported ligands are illustrated for protecting platinum and titanium catalysts using the low cost widely available period 4 metals 2184 comprising iron (Fe), cobalt (Co), and nickel (Ni) as scavenger metals. Accordingly, metal-ligand-hetero-metal (M-L-hM) MOFs 2200 required to covalently bond catalyst metals 2201c labelled C to scavenger metals 2201s labelled S require special organic ligands 2202. In this chemical nomenclature M refers to metal attached to one end of the organic ligand and hM refers to a hetero metal, meaning a metal attached to the other end of the organic ligand 2202 may be different than the metal M.

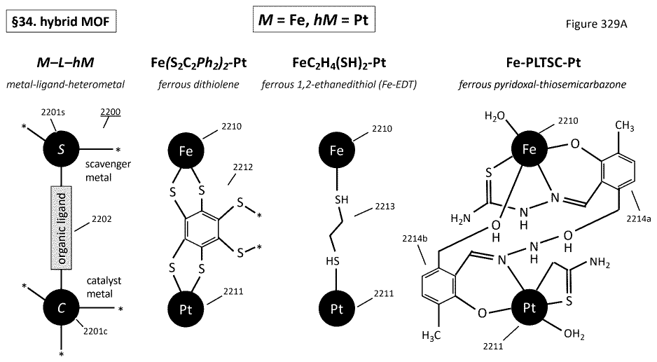

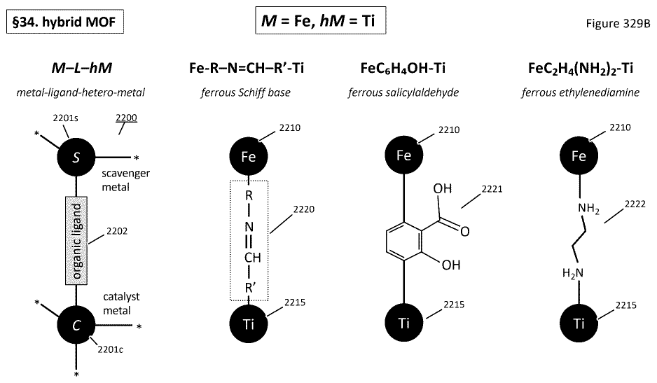

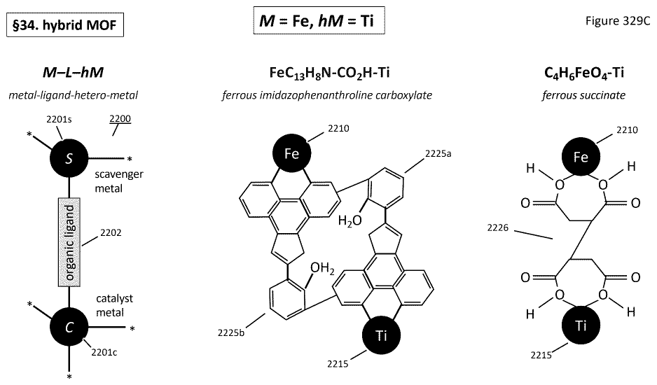

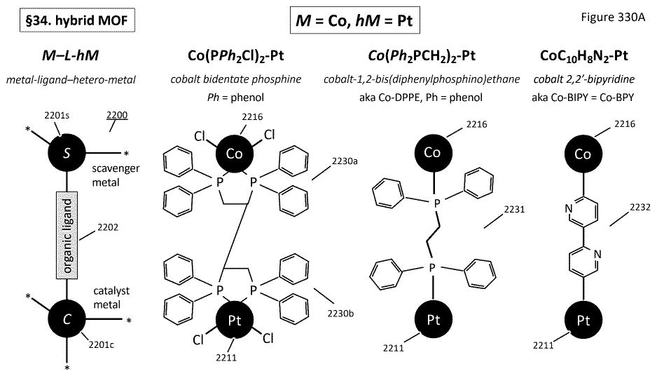

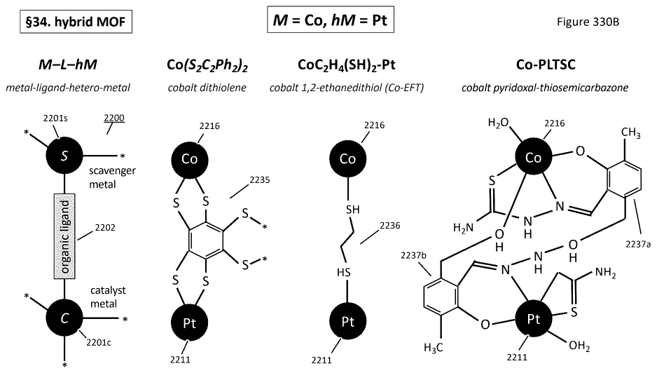

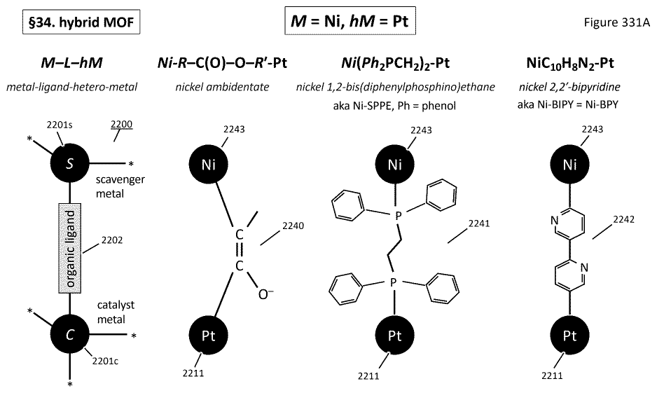

For example, FIG. 329A illustrates organic ligands 2202 bonding iron to platinum where iron Fe 2210 is the scavenger metal 2201s and platinum Pt 2211 is the catalyst metal 2201c protected against poisoning. Exemplary ligands shown include ferrous dithiolene 2212 having the formula (Fe(S₂C₂Ph₂)₂-Pt); ferrous 1,2-ethanedithiol (Fe-EDT) 2213 with the formula (FeC₂H₄(SH)₂-Pt); and ferrous pyridoxal-thiosemicarbazone comprising stereo isomers 2214a and 2214b formulaically described as (Fe-PLTSC-Pt).

FIG. 329B illustrate organic ligands 2202 bonding iron to titanium where iron Fe 2210 is the scavenger metal 2201s and titanium Ti 2215 is the catalyst metal 2201c protected against poisoning. Exemplary ligands shown include ferrous Schiff base 2220 with the formula (Fe—R—N═CH—R′—Ti), ferrous salicylaldehyde 2211 with the formula (FeC₆H₄OH—Ti), and ferrous ethylenediamine 2222 formulaically as (FeC₂H₄(NH₂)₂—Ti).

Other Fe-L-Ti ligands shown in FIG. 329C include ferrous imidazophenanthroline carboxylate comprising stereo isomers 2225a and 2225b having a formula (FeC₁₃H₈N—CO₂H—Ti), and ferrous succinate 2226 with the formula (C₄H₆FeO₄—Ti).

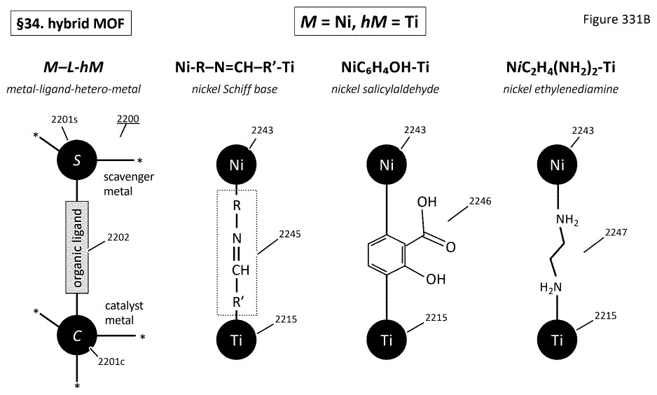

FIG. 330A illustrates organic ligands 2202 bonding cobalt to platinum where cobalt Co 2216 is the scavenger metal 2201s and platinum Pt 2211 is the catalyst metal 2201c protected against poisoning. Exemplary ligands shown include cobalt bidentate phosphine comprising stereo isomers 2230a and 2230b with the formula (Cp(PPh₂Cl)₂—Pt) where Ph stands for the aromatic ring phenol; cobalt-1,2-bis(diphenylphosphino)ethane aka Co-DPPE 2231 with a formula (Co(Ph₂PCH₂)₂—Pt); and cobalt-2,2′-bipyridine aka Co-BIPY=Co-BPY 2243 formulaically as CoC₁₀H₈N₂—Pt.

Other Co-L-Pt organic ligands shown in FIG. 330B include cobalt dithiolene 2235 having the formula (Co(S₂C₂Ph₂)₂-Pt); cobalt 1,2-ethanedithiol (Co-EDT) 2236 with the formula (CoC₂H₄(SH)₂—Pt); and cobalt pyridoxal-thiosemicarbazone comprising stereo isomers 2237a and 2237b formulaically described as (Co-PLTSC-Pt).

FIG. 331A illustrates organic ligands 2202 bonding nickel to platinum where nickel Ni 2243 is the scavenger metal 2201s and platinum Pt 2211 is the catalyst metal 2201c protected against poisoning. Exemplary ligands shown include nickel ambidentate 2240 with the formula Ni—R—C(O)—O—R′—Pt; nickel-1,2-bis(diphenylphosphino)ethane aka Bi-DPPE 2241 with a formula (Ni(Ph₂PCH₂)₂—Ni); and nickel-2,2′-bipyridine aka Ni-BIPY=Ni-BPY 2242 formulaically as NiC₁₀H₈N₂—Ni.

FIG. 331B illustrates organic ligands 2202 bonding nickel to platinum where nickel Ni 2243 is the scavenger metal 2201s and titanium Ti 2247 is the catalyst metal 2201c protected against poisoning. Exemplary ligands shown include nickel Schiff base 2245 with the formula (Ni—R—N═CH—R′—Tu), nickel salicylaldehyde 2246 with the formula (NiC₆H₄OH—Ti), and nickel ethylenediamine 2247 formulaically as (NiC₂H₄(NH₂)₂—Ti).

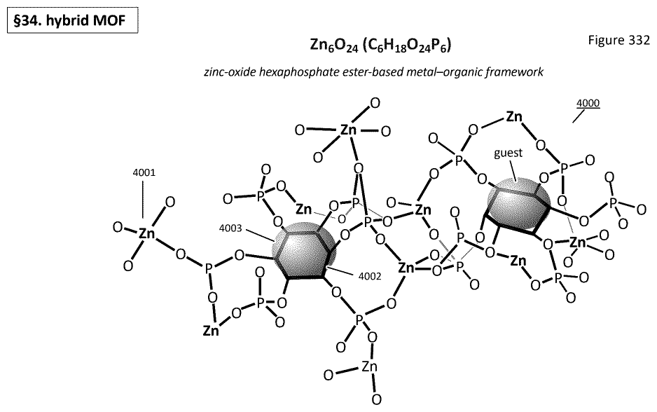

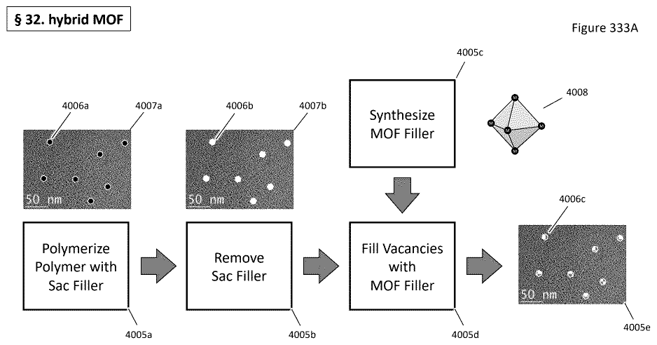

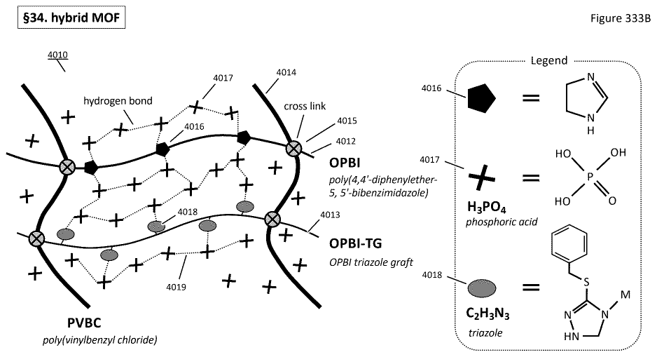

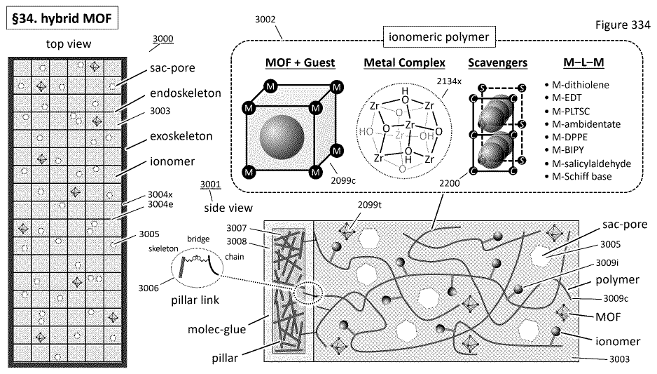

FIG. 332 illustrates a hexaphosphate ester MOF of zinc oxide forming an acid-stable hexaphosphate ester based metal-organic framework for polymer composites applicable for use in proton exchange membranes and filters.

Although the MOFs described can be included in a polymer during molding, infusing MOFs into a polymer after polymerization is difficult because of the limited size and density of channels and pores present in most polymers. Made in accordance with this invention, one solution to this challenge is to employs the sacrificial filler process described previously herein. As illustrated in FIG. 333A, the process step 4005a involves copolymerizing a sacrificial filler with a polymer thereby forming membrane 4007a containing sacrificial fillers 4005a. In step 4005b following polymerization a solvent is used to remove the sacrificial filler from the polymer matrix.

For example if the polymer is PFSA and the filler in sucrose, water can remove the sugar from the polymer without damaging the PFSA material. The resulting membrane 4007b retains voids 4006b, i.e. chambers and holes where the sucrose previously resided. In step 4005c, MOF filler 4008 is synthesized and mixed into solution. In step 4005d the membrane is treated with the MOD laden solution, infusing the MOF particles into the polymeric matrix filling the voids with MOF nanoparticles 4006c resulting in functionalized membrane 4005e.

FIG. 333B illustrates a triazole based MOF can be employed to form proton transport channels in high-temperature proton exchange membranes.

In summary, membrane top view 3000 and membrane side view 3001 in FIG. 334 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise any fluorocarbon or hydrocarbon polymer including sulfonated poly(ether-ether-ketone) (SPEEK), poly(vinylidene fluoride) (PVDF), poly(vinylpyrrolidone) (PVP), poly(vinyl alcohol) (PVA), chitosan (CS), and/or poly(vinylbenzyl chloride) 4014 optionally blended with other homopolymers, heteropolymers, copolymers including poly(4,4′-diphenylether-5, 5′-bibenzimidazole) (OPBI) 4012 and OPBI grafted to triazole 4013, thereby controlling varying degrees of film crystallinity and anisotropy to form a hybrid copolymer;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, and sulfobutyl groups;
where ionomeric polymer 3002 may include ionic fillers including metal oxide frameworks (MOFs) 2099 comprising various geometries such as cubes, trapezoids, reflected trapezoids, pentahedral drums, octahedral drums, cubic scaffolds, interlaced cubic scaffold with or without guest molecules, metal complexes 2134x comprising metal oxides and salts of manganese, aluminum, chromium, zinc, iron, and zirconium e.g. Zr₆O₄(OH)₄, Zn₄O(CH₃CO₂)₆, C₂₄H₁₅ClFe₃N₃O₁₃, {([ZnL(BPE)_{0.5}]·0.5(H₂BPE)·2(NH₃)·4(H₂O))ₙ}, chromium terephthalate, MIL-53, and MOFs with functionalized ligands including NH₂, SO₃H, ZIF;
where ionomeric polymer 3002 may include MOFs containing active metallic catalysts, ionomers, and platinum group metals such as Pd, Pt, Ir, and Au bound by ligands to metallic carbon-monoxide scavengers such as iron (Fe), cobalt (Co), and nickel (Ni), where metal ligand bonds may include iron dithiolene (Fe(S₂C₂Ph₂)₂) where Ph means phenol, iron 1,2-ethanedithiol (FeC₂H₄(SH)₂), iron pyridoxal-thiosemicarbazone (Fe-PLTSC), iron salicylaldehyde (FeC₆H₄OH), iron Schiff base (Fe—R—N═CH—R′), iron ethylenediamine (Fe(C₂H₄(NH₂))₂), iron imidazophenanthroline carboxylate (FeC₁₃H₈N—CO₂H), iron succinate (C₄H₆FeO₄), cobalt bidentate phosphine (Co(PPh₂Cl)₂) where Ph means phenol, cobalt 1,2-bis(diphenylphosphino)ethane (Co(Ph₂PCH₂)₂), Co-2,2′-bipyridine (Co-C₁₀H₈N₂), cobalt dithiolene (Co(S₂C₂Ph₂)₂) where Ph means phenol, cobalt 1,2-ethanedithiol (Co)C₂H₄(SH))₂), cobalt pyridoxal-thiosemicarbazone (Co-PLTSC), nickel ambidentate (Ni—R—C(O)—O—R′), nickel 1,2-bis(diphenylphosphino)ethane (Ni((Ph₂PCH₂))₂) where Ph means phenol, nickel 2,2′-bipyridine (NiC₁₀H₈N₂), nickel Schiff base (Ni—R—N═CH—R′), nickel salicylaldehyde (NiC₆H₄OH), and nickel ethylenediamine (NiC₂H₄(NH₂)₂);
where metal nodes in a MOF framework may comprise metal oxides or metal complexes 21354x such as basic zinc acetate ((Zn₄O(CH₃CO₂)₆);
where metal nodes in a MOF may comprise a heterogenous mix of metals or metal complexes including active ionomers or catalysts and conversely comprising “scavenger” metals able to sequester carbon monoxide and other toxins to prevent (or reduce) polymer contamination and chemical poisoning of the ion exchange membrane;
where ionomer or catalyst functional groups may comprise the MOF metal nodes, the MOF organic ligands and link thereto, or guest atoms or ions captured or contained within a MOF cage;
where scavenger metals or scavenger compounds may comprise the MOF metal nodes, the MOF organic ligands and link thereto, or guest atoms or ions captured or contained within a MOF cage;
and where ionomer or catalyst functional groups within the MOF framework may be interleaved with scavenger metals or scavenger compounds;
where ionomeric polymer 3002 may comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

Metal organic frameworks comprise fillers and dopants that may be incorporated into a polymer matrix or applied as a coating. They do not comprise the polymer matrix itself.

Examples of MOF doped membranes include fluorocarbons such as PFSA, PFSA-PTFE, PFIA, PFSA-PVA-PTFE; hydrocarbons such as SPA-PVA, SPAES, sPEEK, sPEES, sPVA, and SPA-PVA; phenyl based polymers such as phenylene-benzimidazole (PBI) and poly(vinylbenzyl chloride) (PVBC); polysaccharides such as chitosan, as well as grafted polymers.

MOF fillers may comprise any number of geometries including convex coordinations (stars, clusters), and convex cage-like structures (cubes, trapezoids, mirrored trapezoids, rectangular arrays, hexagonal drums, octagonal drums). Metal atoms forming a MOF's geometric corners include any metal including transition metals, refractory metals, noble metals, or metal complexes such as Zr₆O₄(OH)₄, Zn₄O(CH₃CO₂)₆. The metal framework may also form clusters such as sulfonic ferrous metal cluster (Fe-MIL-101-NH₂—PPO—SO₂Cl), chromium terephthalate metal cluster (MIL-101(Cr)), or zinc-oxide hexaphosphate ester (Zn₆O₂₄·C₆H₁₈O₂₄P₆).

The following table describes characteristics of MOF fillers and the membranes they are used as fillers or dopants:

| ionomer | structure | endoskeleton | solvents, X-L | fillers |
|---|---|---|---|---|
| §34A. MOF doped polymers | MOF doped | polymer: matched | solv: catalysts, | MOF fillers: cat |
| PFSA-PTFE, PFIA | and grafted | to IEM polymer | used in forming | MOFs (Pt, Pd, Ti), |
| PFSA-PVA-PTFE | hybrid | pillar: reinforcing | polymers match | scav MOFs (Co, |
| SPAES, sPEEK, sPEES | polymers | fillers (C-fiber, | membrane, not | Ni, Fe), cat-scav |
| sPVA, SPA-PVA | | CNTs) | filler | MOFs, scav guest |
| sPBI, sCS | | | X-L: reagents | MOFs, sMOFs, |
| §34B. MOF graft polymers | | | matching | metal clusters |
| PVBC-co-OPBI-TG | | | membrane | other fillers: |
| | | | polymer | sac filler, CNTs, |
| | | | | oxides, POSS, |
| | | | | NPs, MOFs, PIL |

Catalyst (cat) MOFs include Pt, Pd, and Ti metals. Scavenger (scav) metals bonding carbon monoxide (CO) to prevent poisoning include Fe, Ni, and Co configured on MOF corners or as cage guests. Sulfonated versions (sMOFs) include sulfonic acid groups bound to the organic ligands or to a guest molecule. Made in accordance with this invention a special category of MOF doped IEMs comprises vacancies in the polymer created by the previously described sacrificial filler process where the vacancies are subsequently filled by MOFs.

Endoskeletal support is matched to the membrane chemistry as is applicable solvents, polymerizing agents, catalysts, and cross linkers. Aside from MOFs described herein, membrane fillers and dopants described previously have been omitted for the sake of brevity, and will not be repeated here.

### § 35. Functionalized Hybrid Tungsten (W) Doped Polymer IEMs.

Transition-metal carbides (TMCs) exhibit catalytic properties similar to platinum group metals (PGMs) but at a fraction of the cost. Unfortunately present day TMC synthesis involves numerous unresolved problems preventing their commercial deployment. A more attractive option is to adopt nanofabrication methods to produce nano-TMCs, 1-to-4 microns in size. Benefits include controlled composition, adjustable crystallinity, and tunable sizes. Of the various candidate metals for producing nano-TMCs, the high-temperature refractory metal tungsten and its alloys, including tungsten carbide (WC) and molybdenum tungsten carbide (Mo_{c}W₁₋ₓC).

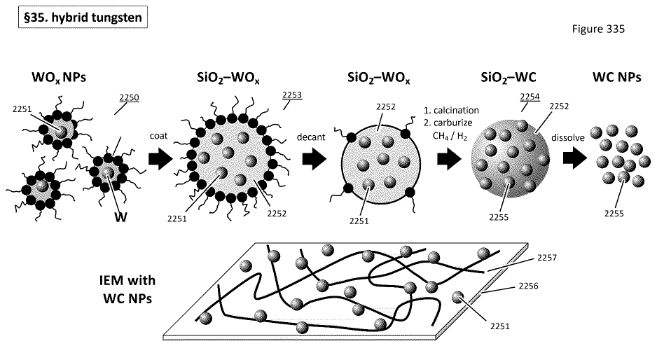

Although not matching the performance of platinum catalysts, applications for lower cost tungsten carbide catalysts includes a diverse range of applications including hydrogenation, dehydrogenation, hydrogenolysis, isomerization, and electrochemistry. FIG. 335 illustrates a process for forming tungsten carbide nanoparticles. The process starts with tungsten oxide nanoparticles (WOₓ NPs) 2250. The WOₓ NPs 2250 are agglomerated and reacted with silicon to form a silicon dioxide 2252 coating the resulting silicon dioxide tungsten oxide complex (SiO₂—WOₓ) 2253. The complexes are then decanted reducing the density of the surface complexes while retaining the silicon dioxide oxide 2252 framework. Subsequent calcination in high heat followed by carburization in methane CH₄ and water (H₂O) produces tungsten carbide (WC) 2235 coated by silicon dioxide (SiO₂) 2252 in SiO₂—WC complex 2254. During this process tungsten oxide WOₓ is transformed into tungsten carbide nanoparticles (WC NPs) 2255. The supporting oxide framework 2252 is then dissolved releasing the tungsten carbide nanoparticles (WC NPs) 2255 which bond onto membrane 2256 comprising polymer backbone 2257. Similar processes involve molybdenum tungsten.

Such sequences include non-sintered, metal-terminated tungsten carbide nanoparticles for catalysis and durable self-hydrating tungsten carbide-based composites as polymer electrolytes applicable in membrane fuel cells and batteries.

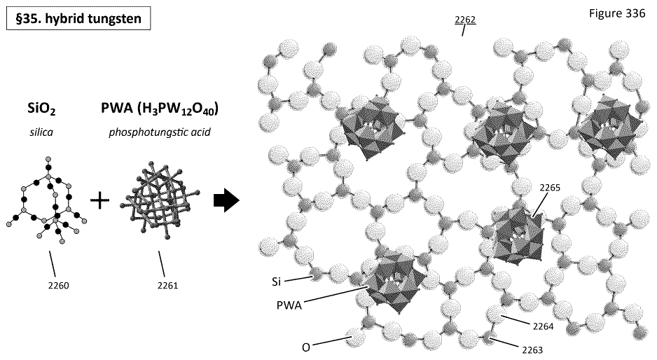

In an alternative approach shown in FIG. 336, silica (SiO₂) 2269 is reacted with phosphotungstic acid (PWA, H₃PW₁₂O₄₀) 2261 to form a complex tungsten nanocluster 2262 held together in a quasi crystal silica framework of silicon 2264 and oxygen 2263. An exemplary process to fabricate tungsten nanoclusters is described by Wikipedia in a web page entitled “Phosphotungstic acid”. Proton transfer via phosphotungstic acid functionalized mesoporous silica made in accordance with this invention are able enhance conductivity without adversely impacting the structural integrity of a membrane.

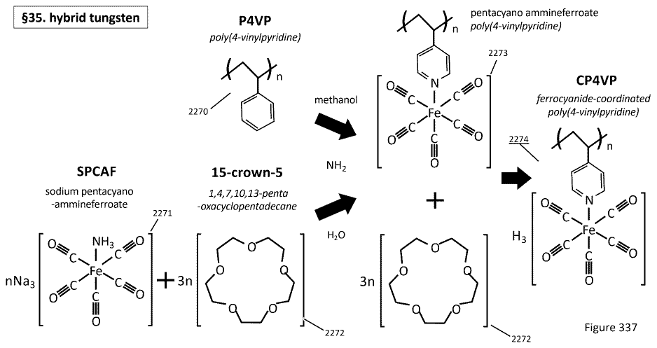

Because of its high temperature capabilities, tungsten can be used to boost conductivity in hydrocarbon based ionomeric membranes. As an example, FIG. 337 illustrates a fabrication process for a ferrocyanide-coordinated poly(4-vinylpyridine) (CP4VP) membrane may include magnetic field alignment during fabrication to align channels forming stable proton-conducting channels in an electrolyte membranes. The manufacturing scalability of such methods are questionable.

As shown, sodium pentacyano-ammineferroate (SPCAF) 2271 is combined with 1,4,7,10,13-penta-oxacyclopentadecane (15-crown-5) 2272 dissolved in solution using water (H₂O) as a solvent and by ammonia (NH₂) and mixed with poly(4-vinylpyridine) (P4VP) 2270 dissolved in methanol (MeOH) to produce pentacyano-ammineferroate poly(4-vinylpyridine) 2273. Thereafter blending pentacyano-ammineferroate poly(4-vinylpyridine) 2273 with 15-crown-5 2272 as reactants produces the polymer ferrocyanide-coordinated poly(4-vinylpyridine) (CP4VP) 2274.

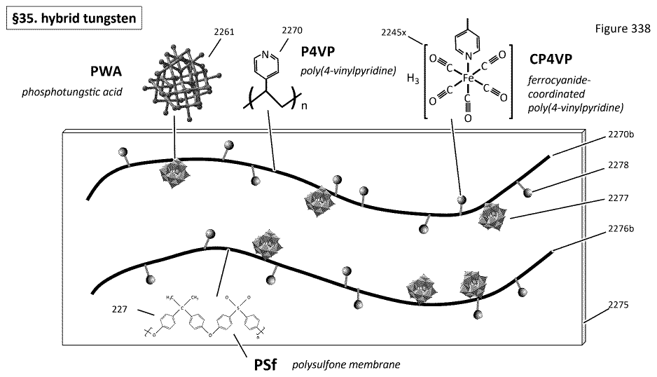

FIG. 338 illustrates a tungsten-doped membrane 2275 containing two polymer backbones. Polymer mainchain 2276b comprises polysulfone (PSf, PSU) 2276 while a second polymer backbone 2270b comprises the polymer poly(4-vinylpyridine) P4VP 2270. Ionomers 2278 comprise ferrocyanide-coordinated poly(4-vinylpyridine) 2245x. Membrane 2275 is doped by permanent filler 2277 comprising phosphotungstic acid (PWA) 2261.

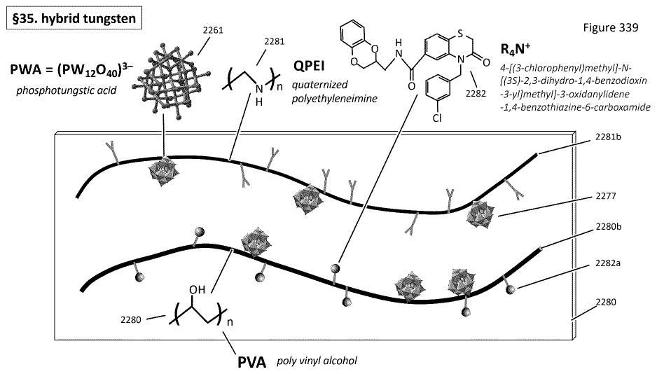

FIG. 339 illustrates a different tungsten-doped membrane 2280, also containing two polymer backbones. Polymer mainchain 2280b comprises poly vinyl alcohol (PVA) 2280 while a second polymer backbone 2281b comprises the polymer quaternized polyethyleneimine (QPEI) 2281. Ionomers 2292a comprise R₄N⁺ 2292. The formula for R₄N⁺ 2292 is 4-[(3-chlorophenyl)methyl]-N-[[(3S)-2,3dihydro-1,4-benzodioxin-3-yl]methyl]-3-oxidanylidene-1,4benzothiazine-6carboxamide.

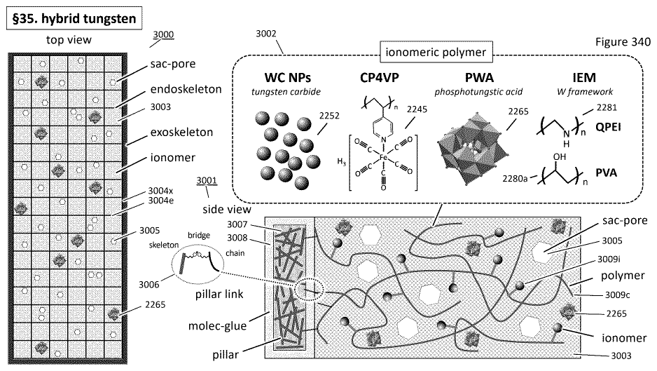

In summary, membrane top view 3000 and membrane side view 3001 in FIG. 340 illustrate a variety of elements of ionomeric polymer 3002 made in accordance with this invention, including separately or in combination inventive matter comprising:
an ion exchange membrane 3003 comprising one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post-casting by a solvent leaving a hole in place of the sac-filler; and/or
where an optional nanocoating such as molybdenum tungsten nanospheres (Mo—W NPs) 2252 is formed atop or within membrane 3003 to enhance membrane conductivity, provide protection against membrane poisoning, control fuel crossover, and/or improve mechanical strength or durability of the film, and/or may also include boron nitride or other materials that inhibit the diffusion of carbon monoxide (CO) into the catalyst layer;
where ionomeric polymer 3002 may comprise any fluorocarbon or hydrocarbon as a mainchain including PFSA-PTFE, PVA 2280a, SPEEK, SPEES, OPBI, polysulfone (PSf, PSU), polyethersulfone (PESf, PES, PESU), polyphenylene sulfone (PPSf, PPSU), P4VP (poly(4-vinylpyridine)) 2245, and/or QPEI (quaternized polyethyleneimine) 2281 optionally blended or cross-linked to other homopolymers, heteropolymers, copolymers, and/or grafted copolymers such as OBPI-TG thereby controlling varying degrees of film crystallinity and anisotropy;
where ionomeric polymer 3002 may comprise sidechains serving as pendants and influencing crystalline regularity, porosity, conductivity, and fuel crossover of the membrane;
where ionomeric polymer 3002 may comprise an ionomer 3009i of reactive sulfonic acid R group —SO₃H, SO₃Na, sulfobutyl groups or ferrocyanide-coordinated poly(4-vinylpyridine) (CP4VP) 2245x, or R₄N (4-[(3-chlorophenyl)methyl]-N-[[(3S)-2,3-dihydro-1,4-benzodioxin-3-yl]methyl]-3-oxidanylidene-1,4-benzothiazine-6-carboxamide));
where ionomeric polymer 3002 may include ionic fillers including perfluoropolyether grafted graphene oxide 3010 or silica-bound clusters such as PWA aka phosphotungstic acid (H₃PW₁₂O₄₀) 2265;
where ionomeric polymer 3002 may contain or comprise carboxylic acid groups —COOH, phosphonic acid groups —PO₃H₂, phosphoric acid group —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

As described, membranes particularly well suited to tungsten doping include those comprising polymers poly(4-vinylpyridine) (P₄VP) and quaternized polyethyleneimine (QPEI); copolymers PSf-co-P4VP and PVA-co-QPEI; and ionomers CP4VP and R₄N⁺. The following table describes characteristics of tungsten doped membranes mad in accordance with this invention including tungsten doped polymers, copolymers, and the application of tungsten as a general conductive filler in polymers: Examples of tungsten doped membranes include fluorocarbons such as PFSA, PFSA-PTFE, PFIA, PFSA-PVA-PTFE; hydrocarbons such as SPA-PVA, SPAES, sPEEK, sPEES, sPVA, and SPA-PVA; phenyl based polymers such as phenylene-benzimidazole (PBI) and poly(vinylbenzyl chloride) (PVBC); polysaccharides such as chitosan, as well as grafted polymers.

| ionomer | structure | endoskeleton | solvents, X-L | fillers |
|---|---|---|---|---|
| §35A. W-doped copolymers | tungsten (W) | polymer: | solv: catalysts, | W fillers: PWA, |
| polymers: PV4P, QPEI | doped hybrid | matched to IEM | used in forming | WC NPs, |
| copolymer: PSf-co-P4VP | polymers and | polymer. | polymers match | other fillers: |
| copolymer: PVA-co-QPEI | copolymers | pillar: reinforcing | membrane, not | sac filler, CNTs, |
| ionomers: CP4VP, R₄N⁺ | | fillers (C-fiber, | filler | oxides, POSS, |
| §35B. W-doped polymers | | CNTs) | X-L: reagents | other NPs, PIL |
| PFSA-PTFE, PFIA | | | match | MOFs |
| PFSA-PVA-PTFE, SPA-PVA | | | membrane | |
| SPAES, sPEEK, sPEES | | | polymer | |
| sPVA, sPBI, sCS | | | | |

Endoskeletal support is matched to the membrane chemistry as is applicable solvents, polymerizing agents, catalysts, and cross linkers. Tungsten dopants and fillers include tungsten carbide (WC) and phosphotungstic acid (PWA). Aside from W-doping, membrane fillers and dopants described previously have been omitted for the sake of brevity, and will not be repeated here.

### § 36. Functionalized Hybrid Zeolite-Doped Polymer IEMs.

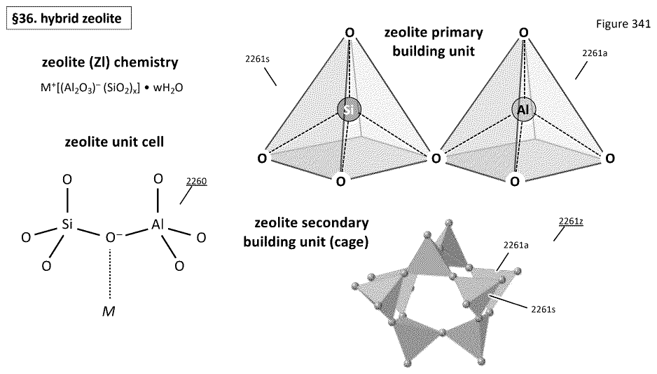

Zeolite (ZI) is a microporous crystalline aluminosilicate useful either as a catalyst or as a filler affecting porosity of a polymer matrix. Primarily comprising a crystalline compound of silicon, aluminum, and oxygen, zeolite is a solid with the chemical constituency M⁺(AlO₂)⁻(SiO₂)ₓ·(H₂O)_{y} where M is a metal ion, or may comprise H⁺, Na⁺ and other cations. Structurally, the FIG. 341 illustrates the structure of zeolite in four different representations (a) as a chemical unit cell, (b) as the chemical structure of a zeolite unit cell 2260, (c) as a zeolite primary building unit comprising silicate 2261s and aluminate 2261a, and (d) zeolite secondary building unit also comprising silicate 2261s and aluminate 2261a groups.

Structural descriptions of zeolite have been categorized in a 2016 PhD study at Univ of Manchester entitled “Membrane electrode assembly modification by zeolite and graphene oxide to reduce methanol permeation in polymer electrolyte membrane fuel cell,” Other description for zeolite structure includes the Wikipedia reference entitled “Zeolite”.

As described formulaically for every aluminate (AlO₂) molecule zeolite contains x silicate (SiO₂) molecules, meaning the variable x represents the silicon-to-aluminum ratio Si/AI. While zeolites with high Si/Al ratios, e.g. for x >3, zeolites are more hydrophobic. At lower x ratios a correspondingly greater preponderance of negatively charged Al—O⁻—Al bonds increases electrostatic attraction of cations, labelled here as M+. The charges attract hydronium ions filling the microporous cavities of zeolite with water. Zeolite crystalline microporous structures having typical diameters of 0.3-0.8 nm, however are not structurally supported by absorbed water, but by rigid covalent bonding.

Accordingly the loss of water does not result in collapse of zeolite cavities and channels the way it does in PFSA membranes. The ability to structurally maintain voids within the solid material explains zeolites ability to function as a catalyst over a wide range of relative humidities without loss of structural integrity. The catalytic capability of zeolite makes it applicable, as a bulk membrane dopant, as a membrane surface coating, and as an interfacial layer between membranes and catalysts or gas diffusion layers. It also can be used to functionalize filtration membranes with antibacterial, antioxidative, and anticorrosion properties.

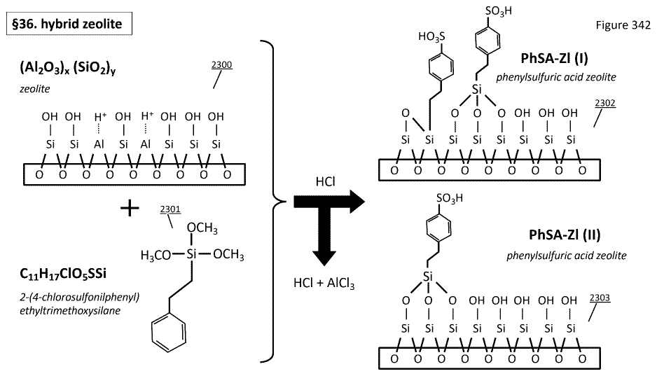

FIG. 342 illustrates an exemplary process for functionalizing a zeolite substrate with sulfonic acid. As shown, zeolite (Al₂O₃)(SiO₂) substrate 2300 is reacted with 2-(4-chlorosulfonilphenyl) ethyltrimethoxysilane) (C₁₁H₁₇ClO₅SSi) 2301 in hydrochloric acid (HCl). The reaction sulfonates nascent zeolite substrate 2300 into phenylsulfuric acid zeolite variants PhSA-ZI(I) 2302 and PhSA-ZI(II) 2303 where the sulfonic acid terminus is bonded to OH groups on the zeolite surface via phenyl and silicon trioxide (SiO₃) intermediaries. The reaction also produces the byproducts hydrochloric acid (HCl) and aluminum chloride (AlCl₃).

Another process for functionalizing a zeolite template is described in a paper “Sulfonic acid functionalization of different zeolites and their use as catalysts in the microwave-assisted etherification of glycerol with tert-butyl alcohol,” in Molecules 12 Dec. 2017. Although the specific reaction is not applicable to forming ionomeric membranes, it does confirm that a zeolite surface can be functionalized by ionomeric groups.

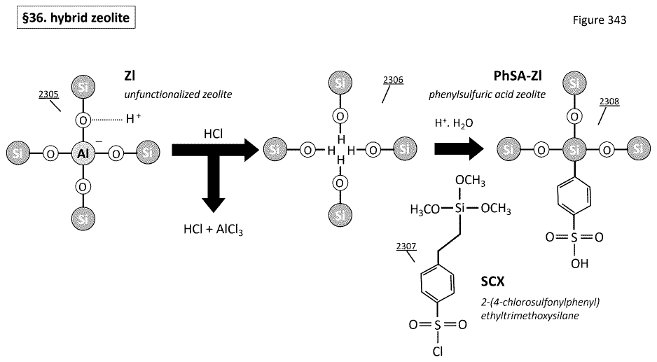

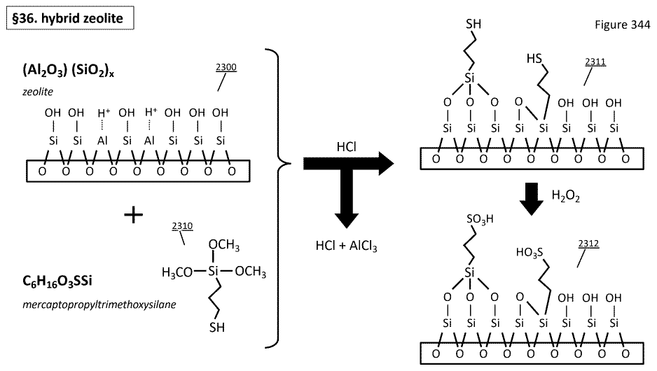

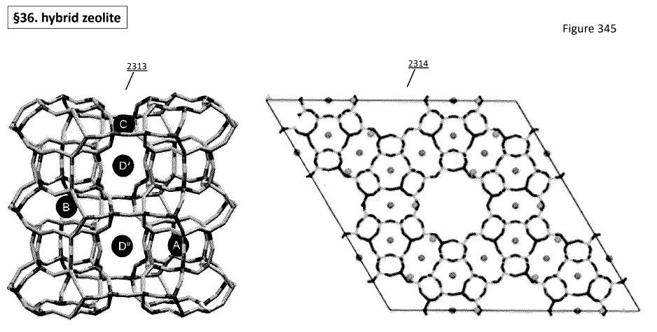

A more simplistic process for functionalizing molecular zeolite with sulfonic acid represented schematically in FIG. 343, the process requires treating a zeolite (ZI) moiety 2305 in hydrochloric acid (HCl) as a substitution reaction by removing center aluminum atoms from aluminate groups synthesizing ionized zeolite intermediary 2306. Subsequent treatment in 2-(4-chlorosulfonylphenyl) ethyltrimethoxysilane (SCX) 2307 functionalizes the modified zeolite into phenylsulfuric acid zeolite (PhSA-ZI) 2308.

In yet another process shown in FIG. 344, zeolite (Al₂O₃)(SiO₂) substrate 2300 is reacted with mercaptopropyltrimethoxysilane (C₆H₁₆O₃SSi) 2310 in hydrochloric acid (HCl). The reaction sulfonates zeolite substrate 2300 by a thiol group, i.e. (—SH), mediated through a silicon trioxide SiO₃ to produce zeolite intermediary 2311. The reaction also produces the byproducts hydrochloric acid (HCl) and aluminum chloride (AlCl₃). Post reaction stabilization with hydrogen peroxide (H₂O₂) converts the —SH thiol group to sulfonic acid (HO₃S) resulting in functionalized zeolite, namely phenylsulfuric acid zeolite 2313.

Like the myriad of silicon-oxide crystals on display in a museum's minerology exhibit, zeolite geometric shapes rely on the reaction conditions when the crystal is formed. Depending on reactants, temperature, pH, concentrations, catalysts, and cooling rates the geometries of zeolite can take on numerous configurations. For example FIG. 345 illustrates the structure of zeolite structure 2313 comprising a porous crystal with numerous pore and channels A, B, C, D and stereo isomeric window D′. Alternatively a tile-like shape includes 2314.

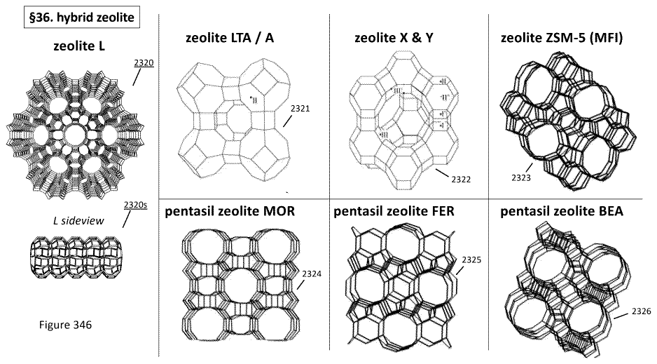

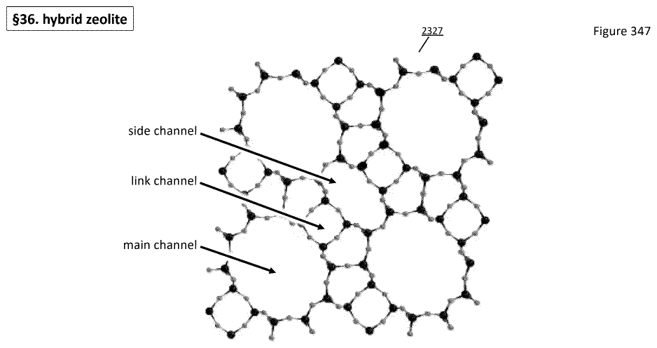

FIG. 346 illustrates various zeolite crystalline structures. Insight in the behavior and structure of zeolite includes a Universitst des Saarlandes PhD thesis entitled “Preferential oxidation of carbon monoxide in microchannels—development of catalysts for the low temperature regime and kinetic study.” Although such studies do not directly apply to ionomeric applications of zeolite they do provide insight into gas flow dynamics and permeability important in this invention. Geometric examples include zeolite L 2320 with sideview 2320s, zeolite LTA/A 2321, zeolite X & Y 2322, zeolite ZSM-5 (MFI) 2323, pentasil zeolite MOR 2324, pentasil zeolite FER 2325.

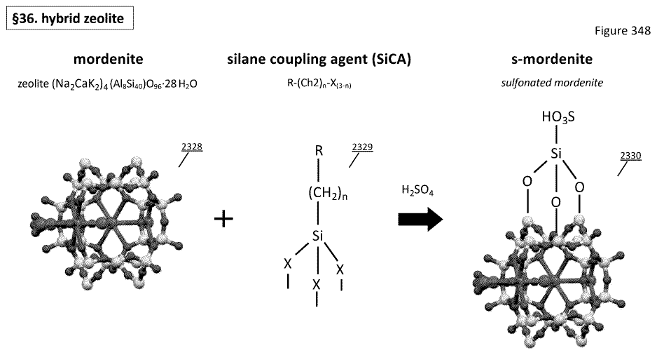

FIG. 347 illustrates an alternative zeolite 2327 crystalline structure, the top view of which illustrates main channels, side channels, and link channels which can affect gas and charge transport. FIG. 348 illustrates a process to sulfonate zeolite comprising (Na₂CaK₂)₄(Al₈Si₄₀)O₉₆·28H₂O also known mordenite 2328. The mordenite is then mixed with silane linker molecule 2329 in sulfuric acid (H₂SO₄). The result is a sulfonic acid functionalize mordenite 2330.

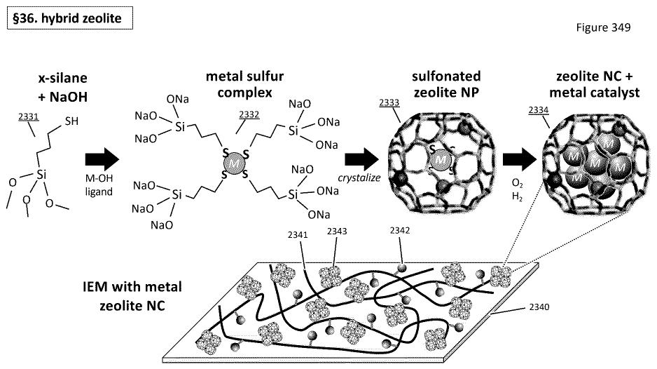

Functionalized zeolite nanoparticles can also be complexed into nanoclusters as shown in FIG. 349 where cross linking silane 2331 is mixed with a metal hydroxide and an organic ligand to form metal sulfur complex 2332. The compound is then crystalized by heating to form sulfonated zeolite nanoparticle 2333 with a core metal atom M. Further heat treatment in hydrogen and oxygen in solution with metal catalysts agglomerate the metal into a shared crystal structure referred to here as nanocluster 2334. Membrane 2340 includes polymer 2341 with ionomer 2342 along with dopant nanocluster 2334.

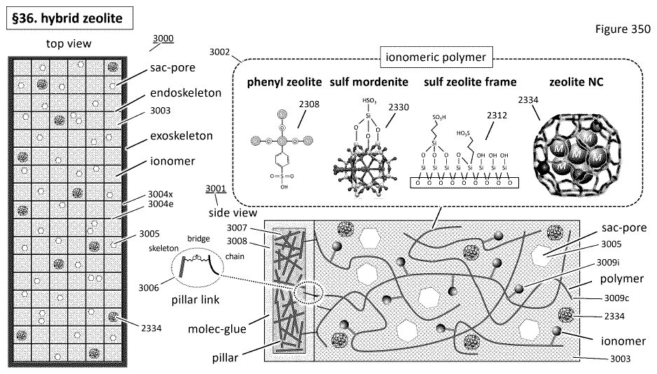

In summary, membrane top view 3000 and membrane side view 3001 in FIG. 350 illustrate a variety of elements of ionomeric polymer 3002 made in accordance with this invention, including separately or in combination inventive matter comprising:
an ion exchange membrane 3003 composed of one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise a fluorocarbon or hydrocarbon polymer as a mainchain optionally blended or cross linked to other homopolymers, heteropolymers, copolymers, thereby controlling varying degrees of film crystallinity and anisotropy;
where ionomeric polymer 3002 may comprise sidechains serving as pendants and influencing crystalline regularity, porosity, conductivity, and fuel cross-over of the membrane;
where ionomeric polymer 3002 may include zeolite fillers including phenyl zeolite 2308, sulfonated mordenite 2330, sulfonated zeolite framework 2312, and zeolite nanoparticles 2334;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The following table describes zeolite doped polymers and copolymers:

| ionomer | structure | endoskeleton | solvents, X-L | fillers |
|---|---|---|---|---|
| §36A. zeolite frameworks | zeolite doped | polymer: | solv: catalysts, | zeolite fillers: |
| PhSA-Zl | polymers and | matched to | used in forming | Zl NP, Zl NC, |
| §36B. zeolite doped polymers | copolymers | IEM polymer. | polymers match | s-mordenite |
| PFSA-PTFE, PFIA | | pillar: | membrane, not | other filers: |
| PFSA-PVA-PTFE, SPA-PVA | | reinforcing | filler | sac filler, CNTs, |
| SPAES, sPEEK, sPEES | | fillers (C-fiber, | X-L: reagents | oxides, POSS, |
| sPVA, sPBI, sCS | | CNTs) | match membrane | NPs, MOFs, PIL |
| | | | polymer | |

Examples include phenyl sulfonic acid zeolite based membranes and various zeolite fillers including zeolite nanoparticles, zeolite nanoclusters, and sulfonated mordenite. Endoskeletal support is matched to the membrane chemistry as is applicable solvents, polymerizing agents, catalysts, and cross linkers. Aside from zeolites described herein, membrane fillers and dopants described previously have been omitted for the sake of brevity, and will not be repeated here.

### § 37. Functionalized Acid-Base Polysulfone (PSf) Polymer IEMs.

Some membrane may be considered acid-base ion exchange membranes. An acid-base ion exchange membrane is a type of membrane that facilitates the selective passage of ions between two solutions while preventing the passage of other particles, such as larger molecules or ions of a different charge. These membranes are typically used in processes like electrodialysis, fuel cells, and other electrochemical applications.

The ‘acid-base’ part of the name refers to the functional groups attached to the polymer matrix of the membrane. An acidic ion exchange membrane has sulfonic acid groups (SO₃H), which can release protons (H⁺) and exchange them with other positively charged ions, i.e. cations in the solution. Conversely, a basic ion exchange membrane has amine groups (—NH₂), which can release hydroxide ions (—OH) and exchange them with other anions (negatively charged ions) in the solution.

The main purpose of these membranes is to allow for the selective transport of ions based on their charge and size, balanced reactions required for maintaining charge neutrality across the membrane while allowing for the separation of different substances or the generation of electricity in the case of fuel cells. The acid-base nature of the membrane determines which type of ions it will preferentially transport. An example of a polymer used in acid-base ion exchange membranes is polysulfone. Although a polysulfone heteropolymer IEM is discussed in section § 22, this section describes various polysulfone moieties in terms of acid-base chemistry and features thereof.

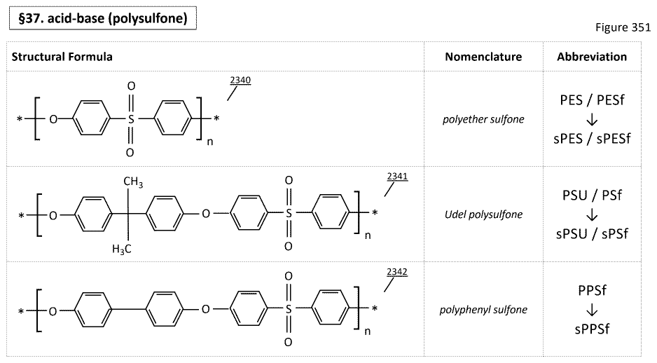

FIG. 351 illustrates various structural isomers of polysulfone including polyether sulfone (PESf, PES) 2340 comprising two hexacyclic hydrocarbon rings forming a linear polymer with one on-chain sulfonyl group of (R—S(═O)₂—R′) and a four-ring variant thereof called polyphenyl sulfone (PPSf, PPSU) 2342. Udel polysulfone PSU 2341, aka PSf, also contains four linearly-configured hexacyclic hydrocarbon rings combined with on-chain methane and sulfonyl moieties. However sulfonyl functional groups located on the mainchain are not electrically active ionomers the way the sulfonic acid terminus of pendants are.

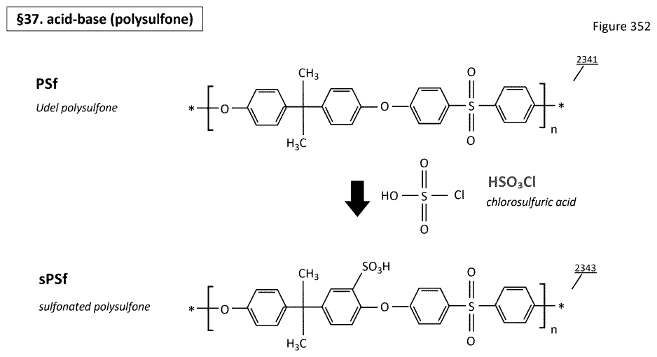

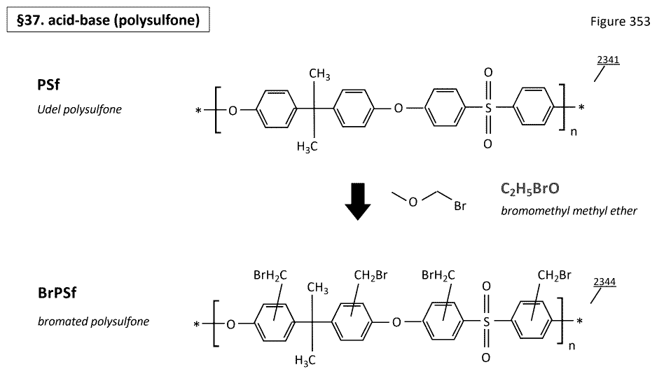

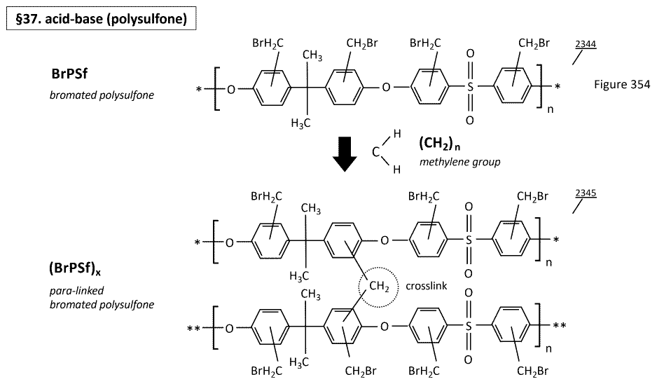

To functionalize a polysulfone polymer into an ionomer, sulfonic acid molecules are attached as pendants on the polymeric backbone using grafting or substitution reactions. One such process shown in FIG. 352 comprises treating Udel polysulfone 2341 with chlorosulfuric acid HSO₃Cl to synthesize sulfonated polysulfone (sPSf, sPSU) 2343. In the process variant shown in FIG. 353 involves converting Udel polysulfone 2341 into single-chain bromated polysulfone BrPSf 2344 using bromomethyl methyl ether C₂H₅BrO. Alternatively, as shown in FIG. 354 methylation of distinct polysulfone (BrPSf) chains 2344 form para-linked bromated polysulfone copolymers via hydrogen bonding and shared amine groups. Cross linking improves film stability and controls swelling.

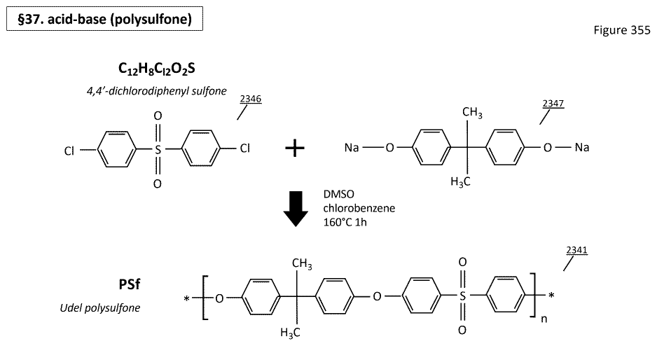

One method for synthesis of Udel polysulfone 2341 shown in FIG. 355. In this process a methylated hydrocarbon 2347 is dissolved in DMSO and chlorobenzene to bond with 4,4′-dichlorodiphenyl sulfone 2346 forming Udel polysulfone 2341. The Udel polysulfone 2341 can then be functionalized by attaching a sulfonic or bromated acid onto the mainchain as a short pendant or alternatively by attaching a longer ionomer functionalized sidechain to form the pendant.

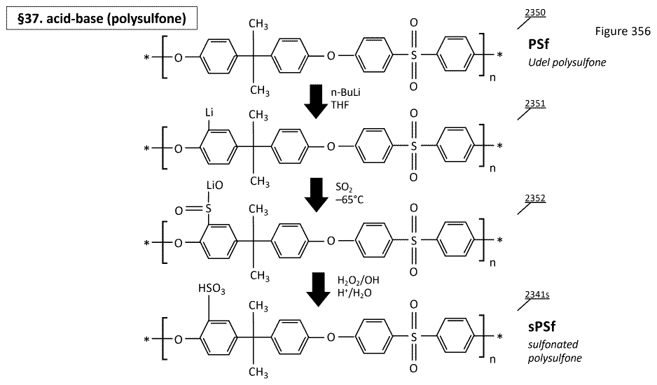

Once exemplary process shown in FIG. 356 involves a substitution reaction of Udel polysulfone 2350 using N-butyllithium aka N-BuLi (C₄H₉Li) and tetrahydrofuran (CH₂)₄O aka THF or oxolane to attach a lithium ion on the terminus benzene ring 2351 followed by SO₂ treatment at −65° C. to substitute lithium sulfur dioxide for the lithium in 2352. Treatment in H⁺/H₂O and H₂O₂/OH converts the LiSO₂ into SO₃H completing the polymer functionalization to produce sulfonated polysulfone sPSf 2341. A similar process can be used to bromate PSf by attaching BrCH₂ to the mainchain, either of which results in a PSf ionomer suitable as a membrane in fuel cells and in dialysis applications.

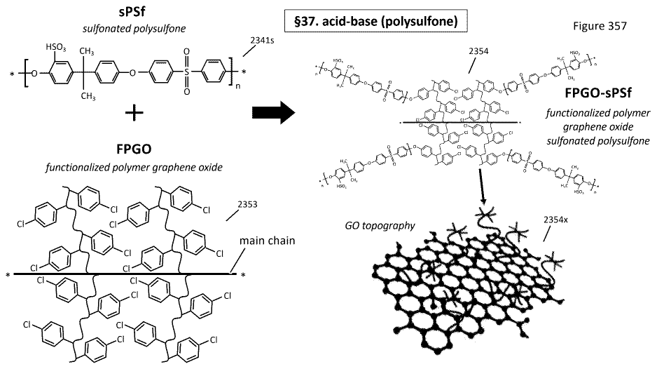

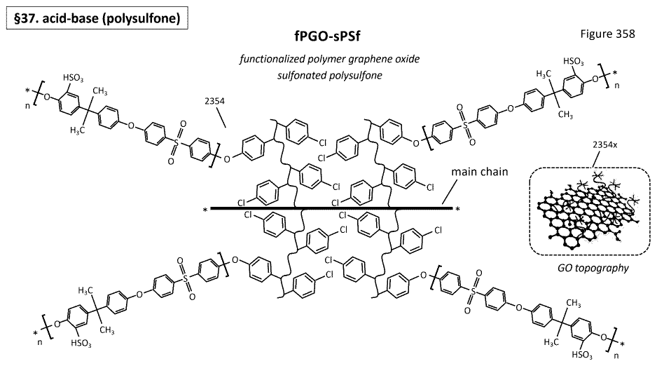

FIG. 357 illustrates synthesis of functionalized polymer graphene oxide with sulfonated polysulfone (FPGO-sPSf) 2354 involves the combination of sulfonated polysulfone sPSf 2341s with functionalized polymer graphene oxide FPGO 2553 comprising a mainchain with pendants of chlorinated benzene groups resulting in the topography represented graphically as GO 2354x. A more detailed illustration of the chemical composition of FPGO-sPSf 2354 corresponding to topography 2354x is depicted in FIG. 358.

Another element of fabricating polysulfone based ion exchange membranes is the inclusion of permanent fillers comprising nanospheres, graphene, carbon nanotubes, and polyoctahedral silsesquioxanes aka POSS, described previously and separately in this application. Their use to enhance the mechanical and electrical properties of polysulfones is therefore exemplary but not limiting or exclusive, and is therefore the description. in this section is not an exhaustive treatment of the molecular or nanostructure additives. One such additive is platinum-titanium nanoparticles or nanospheres such as Pt-Ti NPs of varying chemical compositions.

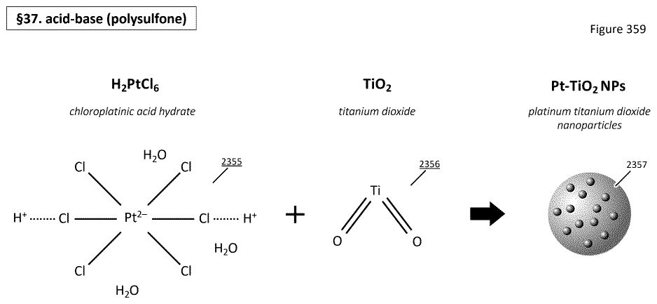

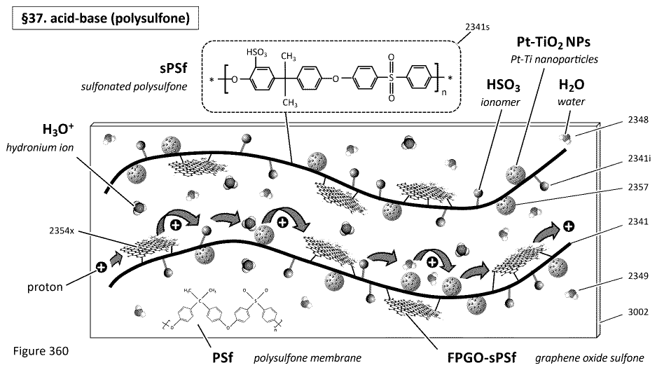

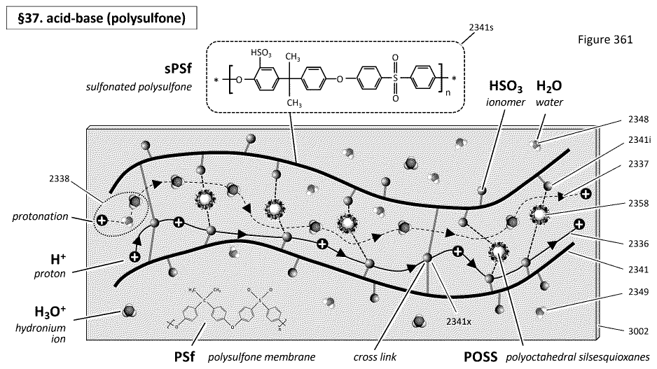

One such nanoparticle shown in FIG. 359 comprises the NP amalgamate platinum titanium dioxide (Pt-TiO₂ NP). Once synthesis method involves a reaction of chloroplatinic acid hydrate (H₂PtCl₆·nH₂O) 2355 with titanium dioxide (TiO₂) 2356 to produce titanium dioxide nanoparticle (Pt—TiO₂ NP) 2357. The inclusion of nanoparticles Pt—TiO₂ NPs 2357 together with functionalized graphene oxide FPGO-sPSU 2354z into polysulfone membrane 3002 is illustrated in FIG. 360.

As shown, polysulfone membrane 3002 comprises a network of polymeric sulfone chains and sulfonated polysulfone chains 2341s forming backbones of the lattice to which pendants with ionomer terminus 2341i attach. During fabrication, shards of functionalized graphene oxide FPGO-sPSf 2354z and nanoparticles Pt—TiO₂ NPs 2357 also bond onto the polysulfone chains 2341 to limit their migration during conduction, generally through hydrogen or Van der Waal bonds. Free floating molecules of water H₂O 2348 and proton ionized water referred to as hydronium ions H₃O⁺ are naturally present within the lattice affecting film conduction and hydration. Charge conduction within the doped polysulfone film can occur by two mechanisms either by proton hopping aka as the Grotthuss mechanism or by vehicular transport.

In charge hopping shown by the arrows protons can jump among the various ionomeric elements, namely from HSO₃ ionomer 2341, Pt—TiO₂ NPs 2357, and functionalized graphene oxide FPGO-sPSf 2354z. In vehicular transport, various forms of water serve as the molecular transport carrier. Although water can chemically bond to nearly any polar molecule to conduct electricity, proton conduction occurs primary by hydronium ions. When water (H₂O) reacts to form a hydronium ion (H₃O), it gains a proton (H⁺) from an acid. This process is known as protonation, which is neither oxidation or reduction. More specifically in redox reactions, oxidation is defined as the loss of electrons, and reduction is defined as the gain of electrons.

Since the formation of a hydronium ion involves the gain of a proton rather than the gain or loss of electrons, it does not fit the definition of oxidation or reduction. Because the hydronium ion has a net positive charge it acts as a cation in a fuel cell flowing from anode to cathode under influence of an electric field, a conduction process referred to as drift. If however the concentration of hydronium ions N in the anode exceeds that of the cathode the concentration gradient also drives a second charge conduction mechanism known as diffusion having a current magnitude per area I/A proportional to the concentration gradient (dN/dx). Total fuel cell current is the sum of its drift and diffusion components offset by losses from charged oxygen molecules flowing from the cathode to anode and counter opposing proton conduction, but still producing heat as an unwanted byproduct.

Both proton hopping and vehicular charge transport mechanisms are illustrated in an alternative version of a polysulfone membrane 3002 shown in FIG. 360 comprising polysulfone 2341, sulfonated polysulfone backbones 2341s, and ionomers 2341i, some ionomers of which function to crosslink 2341x multiple polysulfone chains. Alternatively sulfonated octaphenyl polyhedral silsesquioxanes may cross-link with highly sulfonated polyphenyl sulfone, where as shown in FIG. 361 polymer membranes may be doped with polyoctahedral silsesquioxanes POSS fillers 2358 rather than graphene oxide or nanoparticles.

Despite the filler substitution, conduction mechanisms are similar when proton hopping conduction 2336 occurs primarily through HSO₃ ionomers 2341i and occasionally through ion exchange involving POSS fillers 2358. Unlike nanoparticles, however, POSS fillers 2358 can also enhance vehicular charge transport 2337 by maintaining a higher concentration of hydronium carriers available for charge transport, and to reduce gas permeability to reduce drag from fuel crossover. For clarification purposes, protonation of water involving the process H₂O+H⁺→H₃O is shown in region 2338 where incoming hydrogen ionized by MEA3 catalyst combines with water to form positively charged hydronium ions.

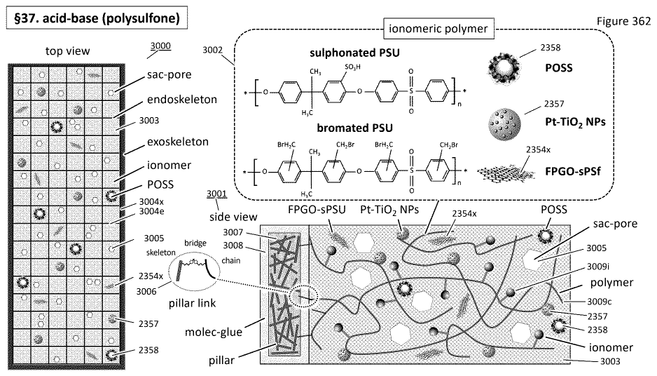

In summary membrane top view 3000 and membrane side view 3001 in FIG. 362 illustrate a variety of elements of ionomeric polymer 3002 comprising polysulfone acid-base polymers made in accordance with this invention, including separately or in combination inventive matter comprising:
an ion exchange membrane 3003 composed of one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 formed by the introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise either sulfonated or bromated polysulfone or other homopolymers, heteropolymers, copolymers, or blends of homopolymers, heteropolymers, copolymers as a mainchain expressing varying degrees of crystallinity and anisotropy;
where ionomeric polymer 3002 may comprise varying lengths of fluorocarbon or hydrocarbon sidechains serving as pendants influencing crystalline regularity, porosity, conductivity ands fuel crossover of the membrane;
where ionomeric polymer 3002 may include functionalized fillers including sPSU doped graphene oxide FPGO-sPSU 2354x, nanoparticles Pt—TiO₂ NPs 2357, and/or polyoctahedral silsesquioxanes POSS 2358;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where ionomeric polymer 3002 may comprise ionomers 3009x that form cross links between and among polysulfone chains.

Endoskeletal pillar materials compatible with polysulfone membranes include: polyether ether ketone (PEEK) and polyetherimide (PEI) bonded to polysulfones using high-performance adhesives resistant to high temperatures; polyamide (PAm) bondable to PSf using adhesives such as epoxy resins or polyurethane adhesives pursuant to surface preparation such as roughening; polyethylene (PE) and polypropylene (PP) although difficult to bond may use epoxies or modified acrylic bonding subsequent to surface treatments such as corona and plasma treatments used to increase the surface energy and improve adhesion; polycarbonate (PC) bondable to polycarbonate using adhesives that are compatible with both materials such as certain epoxies or solvent-based adhesives; acrylonitrile butadiene styrene (ABS) bondable to polysulfones using adhesives like cyanoacrylates, epoxies, or solvent-based adhesives after suitable surface preparation; polyurethanes (PU) using adhesives that form strong bonds with both materials, including polyurethane adhesives and some epoxies; and polybenzimidazole (PBI) with suitable adhesives.

The following table describes characteristics of polysulfone acid-base membranes. As articulated, acid-base polymers of sulfonated polysulfone (sPSU, sPSf), bromated polysulfone (BrPSU, BrPSf), and para-linked bromated polysulfone (BrPSUₓ, BrPSfₓ), exemplify polymers involved in acid base membrane chemistry:

| ionomer | structure | endoskeleton | solvents, X-L | fillers |
|---|---|---|---|---|
| §37A. polysulfone polymers | PSf acid- | polymer (PSf): PEI | other solv: | sulfone fillers: |
| sPSf | base | PEEK, PBI, PAm, PE, | reagents used in | POSS, Pt—TiO₂ |
| BrPSf | fillers & | PP, PC, ABS, PU | forming polymer | NPs, FPGO-sPSf |
| para-linked (BrPSf)ₓ | polymers | polymer (other): | match membrane, | other fillers: |
| §37B. polysulfone filler | | matched to IEM | not filler | sac filler, CNTs, |
| doped | | polymer. | X-L: reagents | oxides, POSS, |
| PFSA-PTFE, PFIA | | pillar: reinforcing | match membrane | NPs, MOFs, PIL |
| PFSA-PVA-PTFE | | fillers (C-fiber, | polymer | |
| SPA-PVA | | CNTs) | | |
| SPAES, sPEEK, sPEES | | | | |
| sPVA, sPBI, sCS | | | | |

Solvents used in forming polysulfone polymers include N-methylpyrrolidone (NMP), N,N-dimethylacetamide (DMAc), N,N-dimethylformamide (DMF), chloroform (CHCl₃), dimethyl sulfoxide (DMSO), or cadmium chloride (CdCL₂). Catalysts and reagents beneficial in polymerizing polysulfone membranes and cross linking them to other polymers include Friedel-Crafts catalysts such as ferric chloride (FeCl₃, iron (III) chloride) or antimony pentachloride (SbCl₅). Cross linking of polysulfone can be performed by 4,4′-trimethylene bis(1-methylpiperidine) (BMP) or by photoinduced cross linking in 2,4,6-trimethylbenzoyl-diphenyl-phosphine oxide (TPO) and trimethylolpropane tri-acrylate (TMPTA).

Acid base polymer specific fillers include polyoctahedral silsesquioxanes (POSS), platinum titanium dioxide nanoparticles (Pt—TiO2 NPs), and functionalized poly graphene oxide sulfonated polysulfone (FPGO-sPSf). Other membranes fillers and dopants were described previously and for brevity's sake, will not be repeated here.

### § 38. Functionalized Anhydrous Poly-Bibenzimidazole (PBI) Polymer IEMs.

Another class of high performance acid-base polymers comprising robust polymeric mainchains and strong intermolecular hydrogen bonding is polybenzimidazoles (PBIs). PBIs are noteworthy for their superior material properties of durability, heat resistance, mechanical strength, chemical stability, radiation resistance, and stable dielectric constants. Non electrical applications of PBI polymers include clothing for harsh environments like firefighters, astronauts, protective work gloves, and welders apparel. PBI has also been adapted for use in proton exchange membranes. Since the pristine polymer is not conductive, PBI must first be functionalized by chemically attaching ionomeric groups onto the polymer to support hopping conduction. Other means to enhance conductivity involve the application of permanent fillers to introduce additional ionomeric groups into the matrix.

Polybenzimidazoles do not however make good aqueous ion exchange membranes as PBI tends to dry out, especially at temperatures of 80° C. or higher. Instead acid-base PBIs are used in anhydrous reactions where acids rather than water are involved in carrier transport and supplying protons. Because of the basic characteristic of the polymer, charge carriers require acids. Unlike. liquid acid fuel cell, these acids remain mostly sequestered in the ion exchange membrane behaving as dopants, i.e. proton sources, analogous to the way boron introduced into silicon crystal creates positive charges called ‘holes’ to transport charge. These acid carriers may comprise phosphoric or sulfuric acid. Alternative acids include phytic acid and phosphotungstic acid. The acids however are unable to damage the PBI polymeric matrix even at temperatures as high as 200° C.

One method to introduce immobile or quasi-mobile acidic proton sources into the polymer matrix is through the use of protic ionic liquids (PIL). A protic ionic liquid is an ionic liquid that is formed via proton transfer from a Brønsted acid to a Brønsted base. As described by the Brønsted-Lowry theory, an acid base reaction involves the transfer betwixt the two thereby conjugating them into a linked pair. By exchanging a proton (H⁺) the acid forms its conjugate base and the base forms its conjugate acid thereby creating a stable link with reversible reactions. In recognition of the discovery a conjugated acid is referred to as a Brønsted acid and its base pair is called a Brønsted base as summarized by the equation

HA+B⇄A⁻+HB⁺

where acid HA is a proton donor which becomes a conjugate base A⁻ after surrendering its proton, and where base B is a proton acceptor becoming a conjugate acid HB⁺ after accepting a proton.

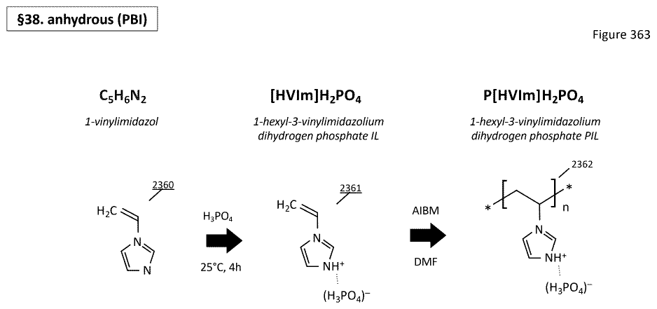

FIG. 363 illustrates a process for forming a poly ionic liquid (PIL). As depicted, 1-vinylimidazol (C₅H₆N₂) 2360 is treated for 4 h at 25° C. in phosphoric acid (H₃PO₄) to produce 1-hexyl-17 3-vinylimidazolium dihydrogen phosphate ionic liquid ([HVIm]H₂PO₄) 2361. Subsequent reaction in azobisisobutyronitrile (AlBN) and dimethylformamide (DMF) results in the protic ionic liquid 1-hexyl-19 3-vinylimidazolium dihydrogen phosphate (P[HVIm]H₂PO₄) 2362.

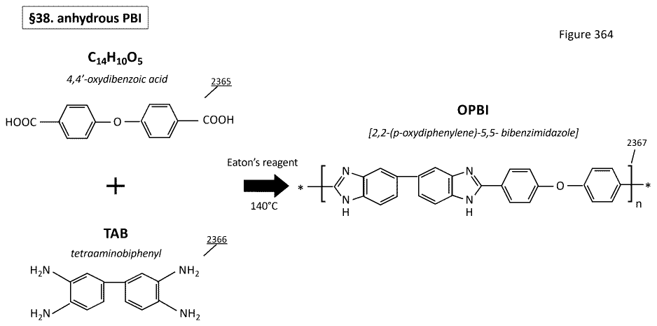

Unlike many water based ion exchange membranes using fluorinated polymers, PBI is composed entirely of aromatic hydrocarbons, i.e. pentagonal and hexagonal carbon ring like structures. Fabrication methods for PBI vary. FIG. 364 illustrates a process for forming OPBI, specifically [2,2-(p-oxydiphenylene)-5,5-bibenzimidazole] 2367. As shown the process involves reacting two biphenyl compounds 4,4′-oxydibenzoic acid (C₁₄H₁₀O₅) 2365 and 3,3′-diaminobenzidine (DAB, (C₆H₃(NH₂)₂)₂)) 2366 in Eaton's reagent at 140° C. Eaton's reagent comprises phosphorus pentoxide solution in methanesulfonic acid.

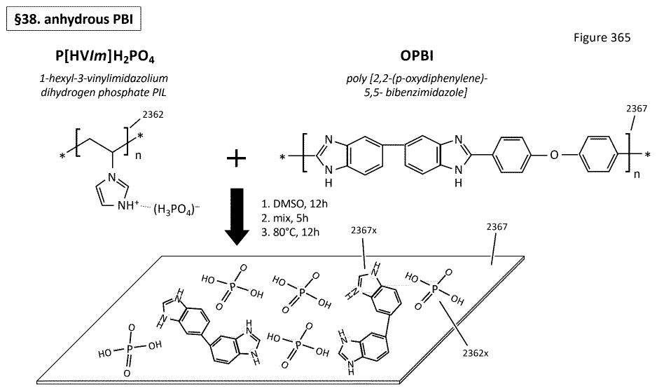

FIG. 365 illustrates a process for forming a phosphoric acid 2362 doped OPBI 2367x ion exchange membrane 2367 by reacting the protic ionic liquid 1-hexyl-3-vinylimidazolium dihydrogen phosphate ([HVIm]H₂PO₄) 2362 with poly[2,2-(p-oxydiphenylene)-5,5-bibenzimidazole]2367 in DMSO for 12 h then allowing the membrane to thoroughly mix for 5 h, then curing it for 12 h at 80° C.

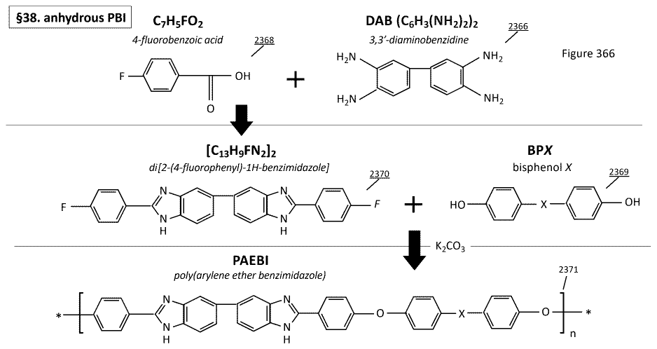

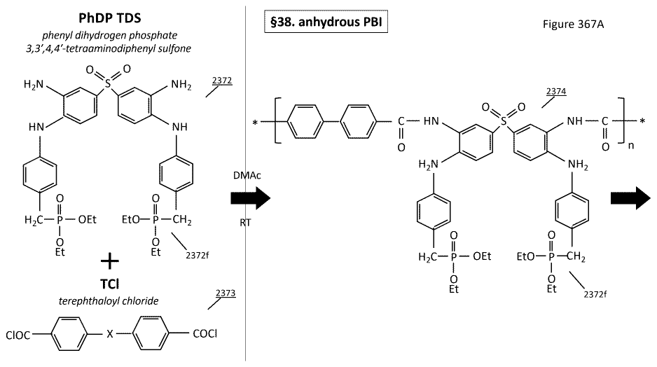

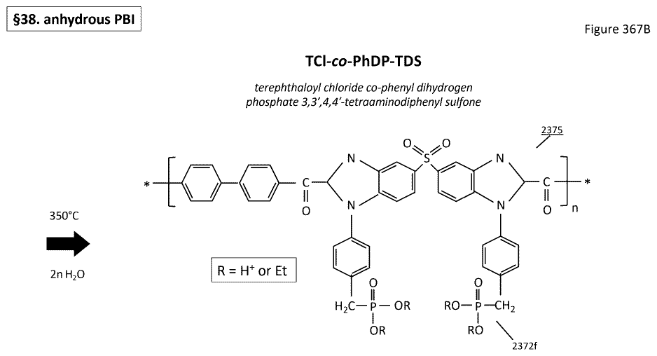

A process for forming a PBI variant—poly(arylene ether benzimidazole) is described in “5.17—Aromatic polyethers, polyetherketones, polysulfides, and polysulfones,” in Chapter 17 of the book Polymer Science: A Comprehensive Reference, © 2012 Elsevier BV. The process show in FIG. 366 illustrates a reaction of 4-fluorobenzoic acid (C₇H₅FO₂) 2368 and 3,3′-diaminobenzidine (DAB, (C₆H₃(NH₂)₂)₂)) 2366 yielding the intermediary monomer di[2-(4-fluorophenyl)-1H-benzimidazole]([C₁₃H₉FN₂]₂) 2370. It is then mixed with bisphenol X (BPX) 2369 in potassium carbonate (K₂CO₃) resulting in forming the PBI based polymer poly(arylene ether benzimidazole) (PAEBI) 2371.

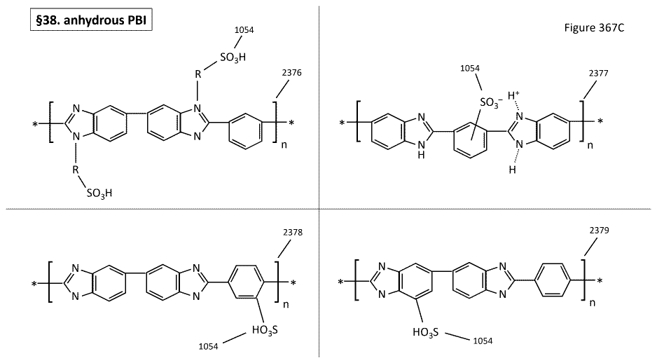

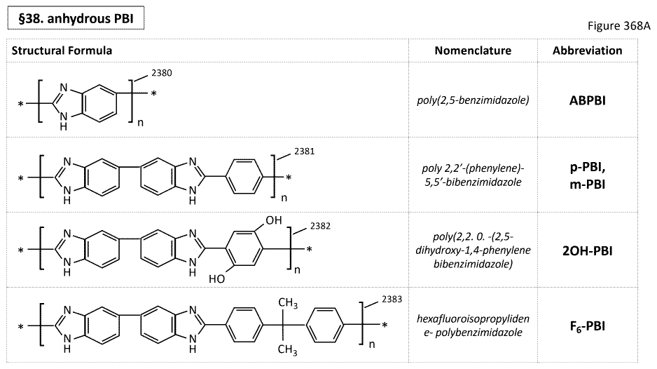

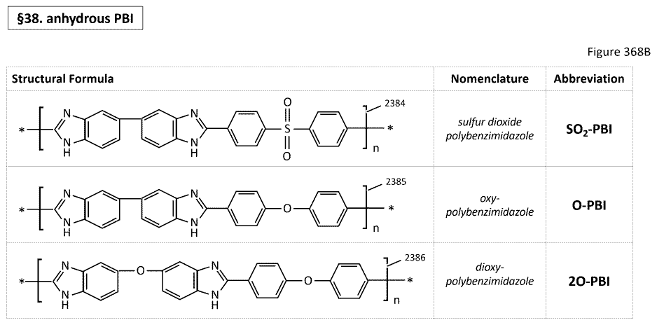

Although PBI is able to conduct protons in the presence of unbound phosphoric acid, embodiments of this invention the acid may comprise a membrane bound ionomer of an acid of phosphorus or of sulfur. Creating a polymer mainchain attached ionomer generally involves a substitution reaction of a membrane side group. For example in FIG. 367A phenyl dihydrogen phosphate 3,3′,4,4′-tetraaminodiphenyl sulfone (PhDP-TDS) 2372 is reacted with terephthaloyl chloride (TCl) 2373 at room temperature (RT) in the polar solvent dimethylacetamide (DMAc) to form intermediate polymer 2374. As shown in FIG. 367B subsequent hydrated curing a 350° C. produces phosphorylated PBI copolymer TCI-co-PhDP-TDS 2375 where the radical R may be hydrogen H⁺ or ethylene Et.

PBI can also form bonds with sulfonic acid groups. FIG. 367C illustrates exemplary variants of sulfonated polybenzimidazole (sPBI). As shown in sPBI moiety 2376, the polybenzimidazole polymer mainchain includes nitrogen bonding of sulfonic acid (SA) 1054 through a linking molecule R. In moiety 2377, SO₃H bonds to the PBI mainchain at two radicals. The anion SO₃ bonds covalently to an aromatic carbon ring such as phenyl while its associated hydrogen cation (H⁺) bonds to mainchain nitrogen electrostatically through hydrogen bonds. In other PBI moieties 2378 and 2379 sulfonic acid 1054 bonds exclusively to various phenyl groups as described in a 2021 PhD thesis at Tech Univ of Denmark entitled “Composite membranes for high temperature polymer electrolyte membrane fuel cells,”

The main polymer of polybenzimidazole varies with the number of aromatic rings in the mainchain. As shown in FIG. 368A, PBI variants include two-ring poly(2,5-benzimidazole) (ABPBI) 2380, and three-ring poly 2,2′-(phenylene)-5,5′-bibenzimidazole (p-PBI, m-PBI) 2381. Another five-ring version poly(2,2,0-(2,5-dihydroxy-1,4-phenylene) aka 20H-PBI 2382 includes OH side groups. Hexafluoroisopropylidene-polybenzimidazole (F6-PBI) 2382 contains six aromatic rings plus two methane groups. Other PBI variants shown in FIG. 368B include sulfur dioxide polybenzimidazole (SO₂—PBI) 2384, oxy-polybenzimidazole (0-PBI) 2385, and dioxy-polybenzimidazole (20-PBI) 2386.

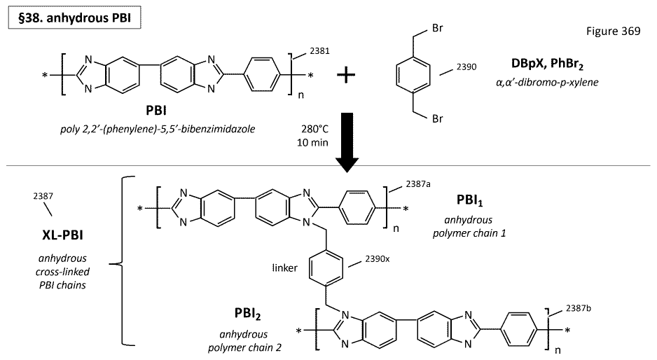

FIG. 369 illustrates the combination of poly 2,2′-(phenylene)-5,5′-bibenzimidazole (PBI) 2381 and α,α′-dibromo-p-xylene (DBpX, PhBr₂) 2390 for 10 min at 280° C., forms two anhydrous polymers PBI₁ 2387a and PBI₂ 2387b cross linked into a copolymer XL-PBI 2387 by phenyl 2390x. Cross linking polymers increases membrane strength while controlling film porosity.

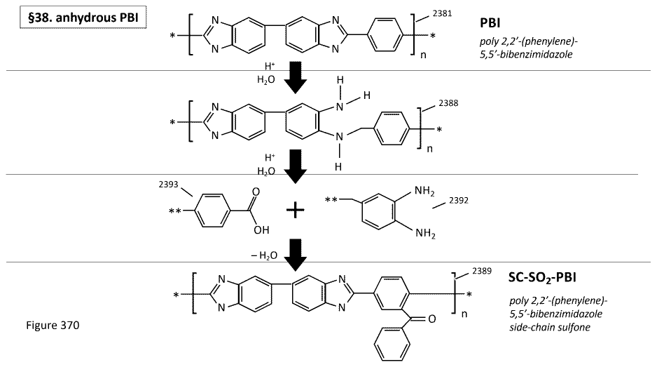

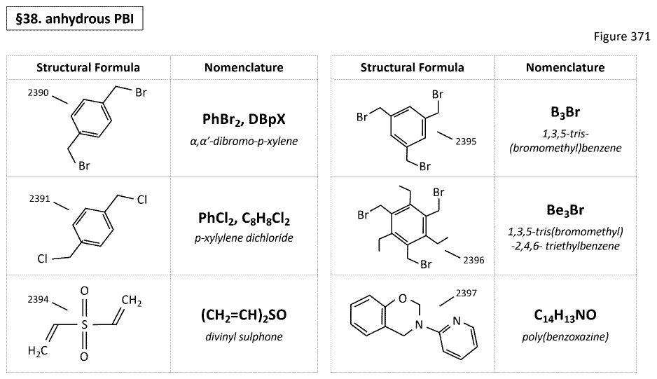

Another modification to PBI polymers is shown in FIG. 370. Starting with poly 2,2′-(phenylene)-5,5′-bibenzimidazole, treatment in acidic water opens one of the aromatic rings, enhancing its reactivity. Combining it with hydroxide and ammonia phenyl groups 2393 and 2392 produces the polymer poly 2,2′-(phenylene)-5,5′-bibenzimidazole sidechain sulfone (SC-SiO₂ PBI) 2389. The sidechain comprises a sulfone molecule sharing one of its phenyl groups with the PBI mainchain. Chemically the sulfone functions like a short pendant onto which functional groups can attach enhancing the capability of the PBI polymer.

FIG. 371 illustrates a number of linker molecules used to modify or crosslink PBI chains illustrating their structural formula and corresponding formula. These include α,α′-dibromo-p-xylene (DBpX, PhBr₂) 2390, 1,3,5-tris(bromomethyl)-2,4,6-triethylbenzene (BeBr₃) 2396, p-xylylene dichloride (PhCl₂, C₈H₈Cl₂), divinyl sulphone ((CH₂═CH)₂SO) 2394, 1,3,5-tris-(bromomethyl)benzene (B₃Br) 2395, poly(benzoxazine) (C₁₄H₁₃NO) 2397.

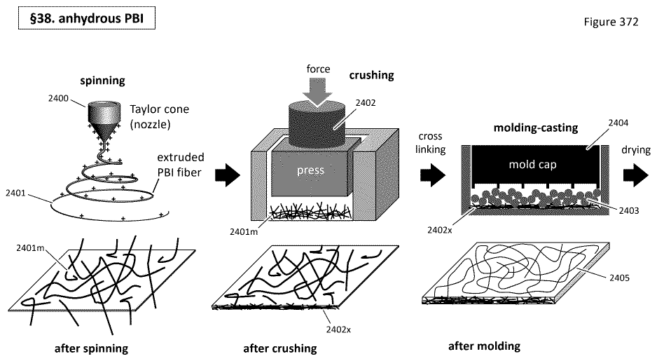

FIG. 372 illustrates the fabrication of nanofibers applicable to polybenzimidazole synthesis including the inventive elements of crushing compaction of electrospun fibers loaded into membrane cast molding. As shown, a Taylor cone 2400 extrudes PBI nanofibers 2401 using the electrospinning process. The PBI nanofiber mat 2401m formed after electrospinning is rough and fibrous. Used in a ion exchange membrane, the nascent PBI nanofibers may protrude from the polymer resulting in excessive fuel crossover. Made in accordance with this invention, excessively long and rigid PBI nanofibers 2401m are crushed mechanical press 2402 resulting in crushed nanofibers 2402x. The crushed nanofibers 2402x is mixed with PBI polymer 2403 for molding casting unit 2404 resulting in smooth surfaced membrane 2405.

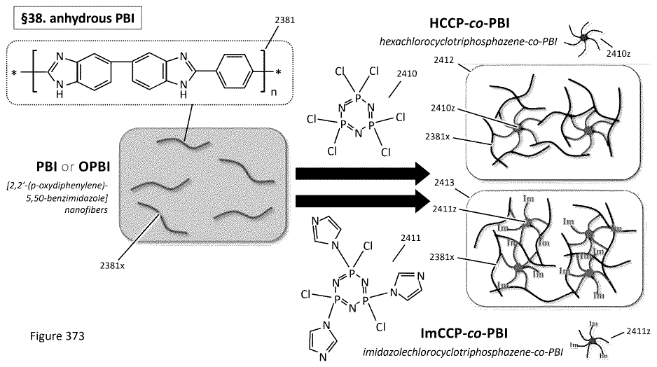

FIG. 373 illustrates exemplary processes for converting [2,2′-(p-oxydiphenylene)-5,50-benzimidazole](PBI) 2381 into various ion exchange membranes by combining it with either hexachlorocyclo-triphosphazene (HCCP) 2410 or imidazolechloro cyclotriphosphazene (ImCCP) 2411. Crosslinking HCCP 2410z with PBI/OPBI nanofibers 2381x produces a membrane comprising the copolymer moiety hexachlorocyclotriphosphazene-co-polybenzimidazole (HCCP-co-PBI) 2412.

Alternatively, crosslinking ImCCP 2411z with PBI/OPBI nanofibers 2381x produces a related but distinct copolymer imidazolechloro cyclotriphosphazene-co-polybenzimidazole (ImCCP-co-PBI) 2413. In both cases, the starfish shaped HCCP 2410z and ImCCP 2411z crosslinkers produce similarly strong PBI copolymers.

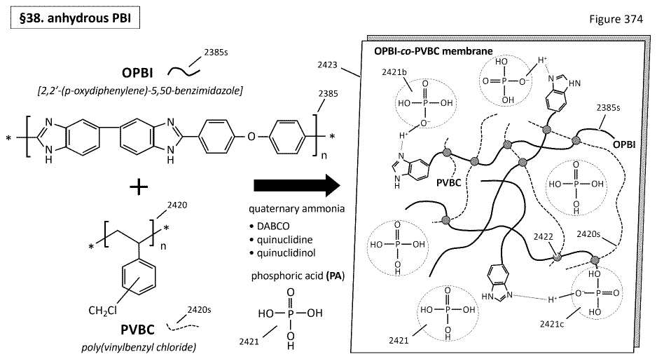

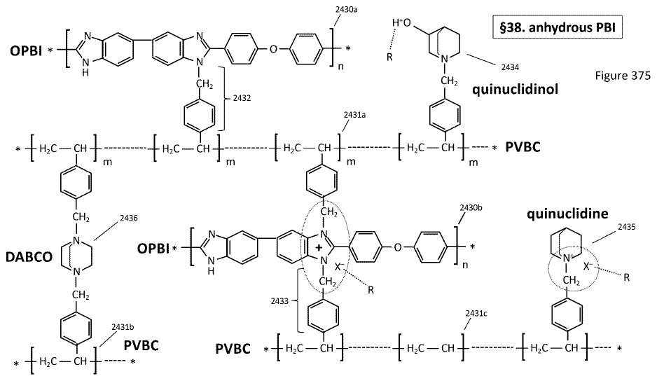

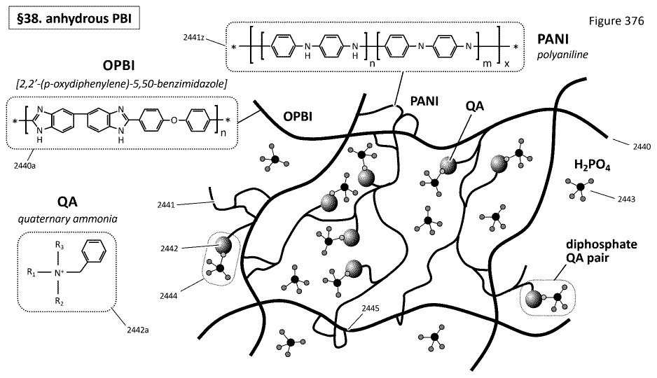

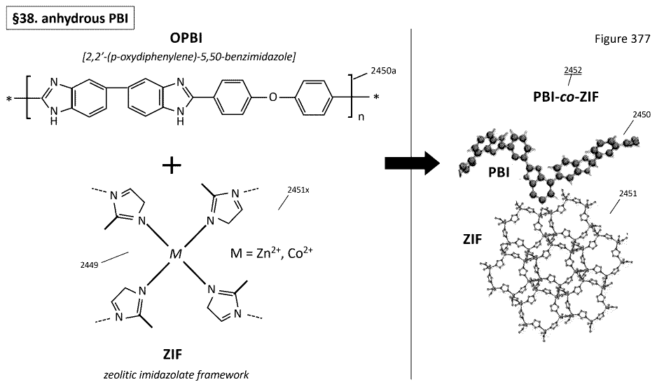

As shown in FIG. 374 [2,2′-(p-oxydiphenylene)-5,50-benzimidazole]OPBI 2385 may also be crosslinked with other hydrocarbon based polymers such as poly(vinylbenzyl chloride) PVBC 2420. The OPBI-co-PVBC copolymer membrane 2423 is formed by treating the reactants in quaternary ammonia comprising for example DABCO, quinuclidine, or quinuclidinol; and doping the mix with phosphoric acid 2421. The two polymer mainchains, i.e. OPBI strands 2385s and PVBC strands 2420s are bonded covalently through cross link points 2422. Phosphoric acid groups in the matrix may be free floating 2421 or hydrogen bonded 2421b to nitrogen atoms on the pyridine termini of OPBI strands 2385s. In other instances the phosphoric acid groups may function as additional cross linkers 2421c covalently bonding onto cross link points 2422 and hydrogen bonding onto OPBI nitrogen atoms.

The structural cross linking of oxydiphthalic polybenzimidazole (OPBI) to poly(vinylbenzyl chloride) aka PVBC using quaternary ammonia to form a OPBI-co-PVBC copolymer membrane is illustrated in FIG. 375, whereby cross linking of PBVC chains 2431a, 2431b, and 2431c to OPBI chains 2430a and 2430b occurs through methylated phenyl groups 2432 and 2433 or through 1,4-diazabicyclo-[2.2.2]-octane (DABCO) 2436. Quinuclidinol 2434 and 2435 facilitate the attachment of a radical group R to the PVBC mainchains. This radical may comprise a phosphoric or sulfonic acid group used to functionalize the membrane and control its conductance.

Another PBI copolymer illustrated in FIG. 376 shows a membrane comprising oxydiphthalic polybenzimidazole (OPBI) 2440a, polyaniline (PANI) 2441a, quaternary ammonia (QA) 2442a, and phosphoric acid (PA, H₂PO₄) 2443. The resulting copolymer OPBI-co-PANI-co-QA comprises OPBI strands 2440 cross linking 2445 to PANI strands 2441 with QA sites 2440 attaching to either polymer backbone. The QA sites form a diphosphate QA pair 2444 with phosphoric acid 2443 molecules, thereby facilitating proton transfer and ionomeric conduction. The properties of a copolymer of polybenzimidazole (PBI) membrane crosslinked with quaternized polyaniline (PANI) include high-temperature operation, enhanced proton conductivity, and improved membrane stability.

FIG. 377 illustrates the combination of [2,2′-(p-oxydiphenylene)-5,50-benzimidazole](OPBI) 2450a with a zeolitic imidazolate framework (ZIF) 2451a. The resulting copolymer PBI-co-ZIF 2452 comprises PBI strands 2450 and ZIF frameworks 2451 secured via hydrogen bonds. Since the ZIF 2451x moiety contains metal groups M which may comprise Zn²⁺, Co²⁺or other metals the ZIF group can acts as a catalyst in hydrogen IEMs or as a metallic ionomer in phosphoric doped PBI membranes.

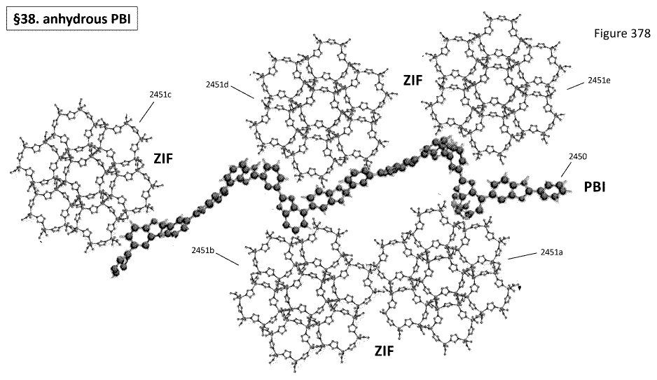

As depicted in FIG. 378 PBI-co-ZIF copolymers can manifest superstructures comprising multiple ZIF groups 2451a through 2451e all bound to a common PBI mainchain 2450. In the sense the IEM may also be considered as a ZIF doped homopolymer rather than a copolymer in which case zeolitic imidazolate frameworks (ZIFs) may be categorized as a permanent filler or dopant rather than a mainchain.

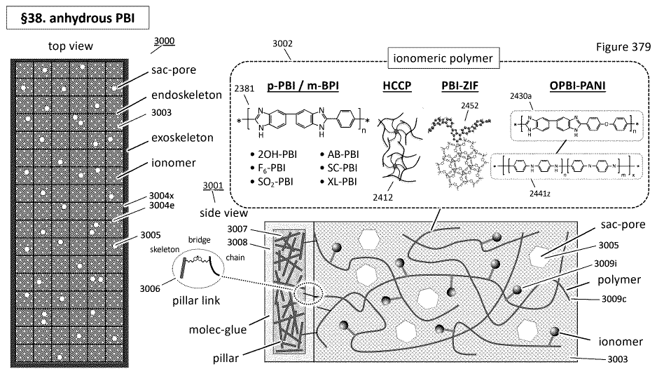

In summary, membrane top view 3000 and membrane side view 3001 in FIG. 379 illustrate a variety of elements of ionomeric polymer 3002 made in accordance with this invention, including separately or in combination inventive matter comprising:
an ion exchange membrane 3003 composed of one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 formed by the introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where anhydrous ionomeric polymer 3002 may comprise poly 2,2′-(phenylene)-5,5′-bibenzimidazole (m-PBI, p-PBI) 2381, oxy-polybenzimidazole (O-PBI) and variants thereof including 20H-PBI, F₆—PBI, SO₂—PBI, sidechain SO₂—PBI (SC-PBI), cross linked PBI (XL-PBI), compound PBI-ZIF copolymers 2452, poly(2,2′-(phenylene)-5,5′-bibenzimidazole)-polyaniline (PBI-PANI) copolymers, phosphoric acid doped copolymer of [2,2′-(p-oxydiphenylene)-5,50-benzimidazole]2430q and poly(vinylbenzyl chloride) 2441z (OPBI-co-PVBC) along with other homopolymers, heteropolymers, copolymers, or blends of homopolymers, heteropolymers, copolymers as a mainchain expressing varying degrees of crystallinity and anisotropy;
where ionomeric polymer 3002 may comprise varying lengths of fluorocarbon or hydrocarbon sidechains serving as pendants influencing crystalline regularity, porosity, conductivity ands fuel crossover of the membrane including cross-linkers α,α′-dibromo-p-xylene, p-xylylene dichloride, divinyl sulphone, (bromomethyl)benzene, tris(bromomethyl) triethylbenzene, and poly(benzoxazine), hexachloro-cyclotriphosphazene, and imidazole-chlorocyclotriphosphazene, and quaternary ammonia including DABCO, quinuclidine, and quinuclidinol;
where ionomeric polymer 3002 may include functionalized fillers; including proton ionic liquid 1-hexyl-3-vinylimidazolium dihydrogen phosphate PIL chemically as P[HVIm]H₂PO₄, and electrospun extruded crushed PBI nanofibers;
where ionomeric polymer 3002 may comprise an ionomer 3009i of reactive sulfonic acid groups —SO₃H, carboxylic acid groups —COOH, phosphonic acid groups —PO₃H₂, phosphoric acid groups comprising —PO₄H₂, imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, or any other acidic group which easily ionizes to donate conducting cations of H⁺, Na⁺, or K⁺ into the solid electrolyte; and finally
where ionomeric polymer 3002 may comprise ionomers 3009x that form cross links between and among PBI chains, PVBC chains, and PANI chains.

Polybenzimidazole used in anhydrous IEMs comprise a diverse spectrum of polymers and copolymers. The two most common classes of PBIs comprise the five aromatic ring moiety named poly 2,2′-(phenylene)-5,5′-bibenzimidazole commonly referred to as p-PBI, m-PBI, or simply PBI and a five aromatic ring variant containing a single oxygen on its mainchain referred to as oxy-polybenzimidazole with the acronyms O-PBI or OPBI. Other variants include the two-ring ABPBI, the dihydroxy 20H-PBI, dioxy 2O-PBI, hexafluorinated F₆-PBI, and sulfur dioxide SO₂—PBI.

PBI may also form heteropolymers such as poly(arylene ether benzimidazole) PAEBI or PBI-ZIF, and sidechain sulfur dioxide SC—SO₂—PBI. PBI copolymers include a terephthaloyl chloride, aminodiphenyl sulfone, dihydrogen phosphate TCI-co-PhDP-TDS; hexachlorocyclotriphosphazene HCCP-co-PBI, imidazolechlorocyclotriphosphazene ImCCP-co-PBI; poly(vinylbenzyl chloride) OPBI-co-PVB; and polyaniline OPBI-co-PANI.

PBI may also form cross links to other PBI mainchains. Ionomeric groups include bound and free floating phosphoric acid, phosphoric protic ion liquids (PILs), sulfonic acid, and quaternary ammonia compounds. The following table describes characteristics of PBI membranes and fillers: Endoskeletal pillars able to bond to polybenzimidazole are limited as PBI comprises a chemical stable high temperature polymer. The only polymeric resins which can bond to PBI comprise are epoxy (EPX) and polyimide (PI). So although these polymers can be used to form carbon filled pillars of the endoskeleton, PI and EPX can also act as an adhesive bridge between PBI and a variety of polymers PB to which cannot bond.

| ionomer | structure | endoskeleton | solvents, X-L | fillers |
|---|---|---|---|---|
| §38. polybenzimidazole | anhydrous | polymers: | solv: CSA, pPA, | PBI fillers: PIL |
| (PBI/OPBI) anhydrous IEM | PBI or OPBI | EPX, PI | NMP, MeSO₃H, | P[HVIm], H₂PO₄, |
| p-PBI, m-PBI | proton | via EPX: GRP, | DMAc | PBI nanofibers, |
| OPBI | conductors | CFRP, AFRP, PE, | X-L: | ZIF |
| PHVIM-H₂PO₄ PIL | | PC, ABS, PAm, | DBpX, PhCₗ₂, | other fillers: |
| 2OH-PBI | | PE, PVC, TPE | (CH₂═CH)₂SO, B₃Br, | sac filler, CNTs, |
| F₆-PBI | | via PI: EPX, PU, | Be₃Br, C₁₄H₁₃NO, PA, | oxides, POSS, |
| SO₂-PBI | | SIL, PTFE, PE, | HCCP, ImCCP, QAs, | NPs, MOFs, PIL |
| 2O-PBI | | PP, PVDF, | DABCO, quinuclidine | |
| PAEBI | | PEEK, | | |
| TCl-co-PhDP-TDS copolymer | | pillar: | | |
| HCCP-co-PBI copolymer | | reinforcing | | |
| ImCCP-co-PBI copolymer | | fillers (C-fiber, | | |
| ABPBI | | CNTs) | | |
| OBPI-co-PVBC | | | | |
| quaternary ammonia link + | | | | |
| DABCO + quinuclidine + | | | | |
| quinuclidinol | | | | |
| PA doped | | | | |
| OPBI-co-PANI copolymer | | | | |

Bonding PBI to polymer pillars via epoxy (EPX) adhesives include polymers such as glass-reinforced plastic (GRP, fiberglass); carbon fiber reinforced polymer (CFRP), aramid fiber reinforced polymer (AFRP); polyurethane (PU); polycarbonate (PC); acrylonitrile butadiene styrene (ABS); polyamide (PAm); polyester (PE); polyvinyl chloride (PVC); and various thermoplastic elastomers (TPEs). Bonding PBI to polymer pillars via polyimide (PI) adhesives include polymers such as epoxy (EPX); polyurethane (PU); silicone (SIL); polytetrafluoroethylene (PTFE); polyethylene (PE); polypropylene (PP); polyvinylidene fluoride (PVDF); polyether ether ketone (PEEK); and itself (PI).

Solvents of PBI include concentrated sulfuric acid (CSA, H₂SO₄); polyphosphoric acid (pPA); N-methyl-2-pyrrolidone (NMP); dimethylacetamide (DMAc); and methane-sulfonic acid (MeSO₃H). PBI is able to respond to a wide spectrum of cross linkers including α,α′-dibromo-p-xylene (DBpX or PhBr₂), 1,3,5-tris(bromomethyl)-2,4,6-triethylbenzene (BeBr₃), p-xylylene dichloride (PhCl₂, C₈H₈Cl₂), divinyl sulphone ((CH₂═CH)₂SO), 1,3,5-tris-(bromomethyl)benzene (B₃Br), benzoxazine (C₁₄H₁₃NO), hexachlorocyclotriphosphazene HCCP, imidazolechlorocyclotriphosphazene (ImCCP), along with quaternary ammonia compounds including 1,4-diazabicyclo-[2.2.2]-octane (DABCO), quinuclidine, quinuclidinol. In some instances phosphoric acid may also provide cross chain bonding through diphosphate QA pairs. PBI specific fillers include protic ion liquids such as P[HVIm], phosphoric acid (H₂PO₄), electrospun and crushed PBI nanofibers, and zeolitic imidazolate framework (ZIF) fillers. Other membranes fillers and dopants were described previously and for brevity's sake, will not be repeated here.

### § 39. Biopolymer IEMs.

Biopolymers are polymers derived from living organisms such as plants, sea creatures, and microbes. Attractive for their promising advantages of biodegradability, biocompatibility, and environmentally friendliness, biopolymers offer a natural alternative to synthetic polymers derived from fluorocarbon forever chemicals and petroleum based plastics. Many biopolymers occur abundantly in nature, offering the prospect for a commercially viable material source with minimal environmental impact. Although these ecofriendly polymetric materials potentially support a wide range of applications, one exceptionally important area of interest is the use of biopolymers in energy technology, including the prospect for fabricating biopolymer-based ion exchange membranes for fuel cells and water electrolyzers.

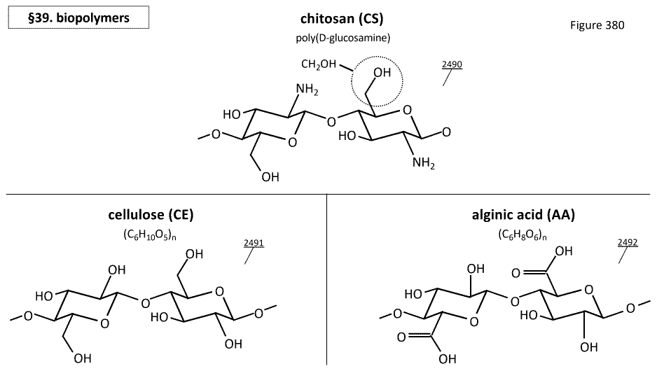

Three most promising biopolymers are depicted in FIG. 380 namely chitosan (CS) 2490, cellulose (CE) 2491, and alginic acid (AA) 3492. Although numerous molecular variants occur in naturel, all three polymers comprise at least two cyclic rings of carbon with one oxygen substitution on each ring. Other molecules form side groups bonded to but located off of the aromatic rings. Although these six sided cyclic rings are sometimes represented as hexagonal geometries, they are more commonly depicted as six sided asymmetric shapes highlighting dissimilar bond lengths, havening a quasi-3D flattened askew shape.

In its two-ring moiety, each ring of chitosan 2490 contains bonds to two oxygens (O), two hydroxides (OH), and one amine (NH₂) group. As shown, the two rings comprise stereo isomers of one another around a horizontal line of symmetry, i.e. where the NH₂ group is located above the molecular main plane in the left sided ring, and below the plane in the right side ring. The chemical formula for the two ring chitosan moiety is C₈H₁₃NO₅ where five carbons occupy each ring and two more bond to the OH groups. Other chitosan moieties such as C₁₂H₂₄N₂O₉ and C₁₈H₃₅N₃O₁₃ include three cyclic rings while C₅₆H₁₀₃N₉O₃₉ comprise nine cyclic rings.

Like chitosan, cellulose (CE) 2491 also comprises a stereo isomer construction symmetric around a horizontal line of symmetry, except that the cyclic rings bond only to oxygen (O) and hydroxide (OH) but with no nitrogen groups. The molecular formula for cellulose is therefore more simply (C₆H₁₀O₅)ₙ. Another related molecule alginic acid (AA) 2492 is similar to cellulose except one on chain carbon per ring bonds to a carboxylic acid groups comprising (—C(═O)—OH). The chemical formula for alginic acid is (C₆H₈O₆)ₙ.

Although chitosan occurs in nature in some fungi such as Mucoraceae, in most general chitosan is synthesized from chitin. Chitin is an abundant naturally occurring polymer coming from the skin of shellfish such as shrimp, lobster, and crab, along with shelled insects and certain fungi. Chitosan can be produced by treating chitin in alkali chemicals or various reagents in order to deacetylate the compound, i.e. by removing some or all of the acetyl groups from chitin. Cellulose, by contrast is pervasive in biosphere forming the cells wall of plants. Commercial sources include the husks of rice, wheat and corn straw, and sugarcane bagasse. On the other hand alginic acid is derived from brown seaweed. Although these biopolymers hold promise as sustainable green-tech polymer sources, they still in their infancy. Among them, chitosan has the most progress to date.

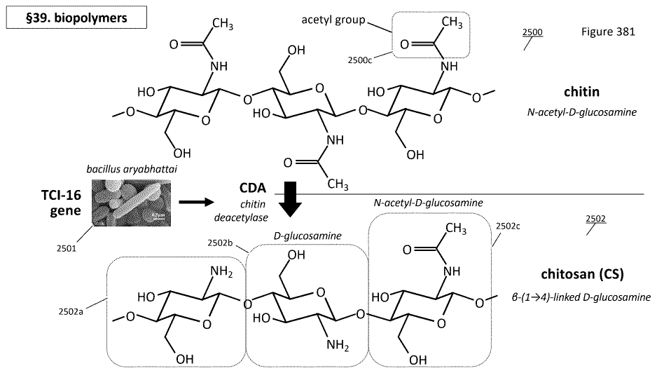

One process to convert chitin into chitosan shown in FIG. 381 involves treating chitin 2500 with the enzyme chitin deacetylase (DCA). The enzyme can be produced synthetically or biologically. e.g. by inserting the endonuclease gene TCI-16 into the bacterium bacillus aryabhattai, which naturally produces the enzyme metabolically. By applying the enzyme DCA to chitin 2500, some of the acetyl groups 2500a are stripped from the molecule to produce chitosan (CS) 2502. As shown in the example chitosan moieties 2502a and 2502b referred to as D-glucosamines, have their acetyl groups completely removed leaving an NH₂ group attached to the cyclic ring. In contrast group 2502c retains is acetyl group attached to chitosan's nitrogen atom, and is appropriately referred to as N-acetyl D-glucosamine. This fact highlights that chitosan is not a single molecule but an aminoglycan family consisting of various β-(1→4)-linked residues of N-acetyl-2 amino-2-deoxy-D-glucose (glucosamine, GlcN) and 2-amino-2-deoxy-d-glucose (N-acetyl-glucosamine, GlcNAc). As such, chitosan is not a single polymer or polymeric structure but a family of molecules differing in composition, size, and monomer distribution. Uses of CS include synthesis of nanoparticles, biocatalysts, and antipathogenic medicinals.

The attractiveness of chitosan as a biologic, enzymatic, or ionomeric material is in part motivated by the numerous bonding points on the molecule capable of being functionalized post polymerization. For example cyclic bound OH groups can be modified by sulfonylation and alkenylation; while the aldehyde group (CHO) can be functionalized through esterification such as sulfation and sulfonation; carboxymethylation; and alkylation.

The aldehyde group (CHO) along with the amine group (NH₂) can also function as graft points for copolymerization; for chemical coupling or crosslinking; or for metal coordination with metal elements, complexes, and MOFs. Alternatively, the oxygen linker is subject to glycosidic bond cleavage but also adversely subject to degradation. The generalized production of chitosan with DCA is described by Wikipedia on their page “Chitosan” and will not be considered further here.

Because of its numerous accessible bonding sites, chitosan forms numerous functionalized moieties including N-succinyl chitosan, chitosan-4-mercaptobenzoic acid, chitosan-g-poly(acrylic acid), carboxymethyl chitosan, trimethyl chitosan, N-palmitoyl c chitosan, N-octanoyl chitosan, N-myristoyl chitosan, N-caproyl chitosan, and chitosan-g-beta-cyclodextrin. The vast majority of these polymers are used in medical and pharmaceutical applications, and are insightful inasmuch that they highlight the versatility of chitosan bonding.

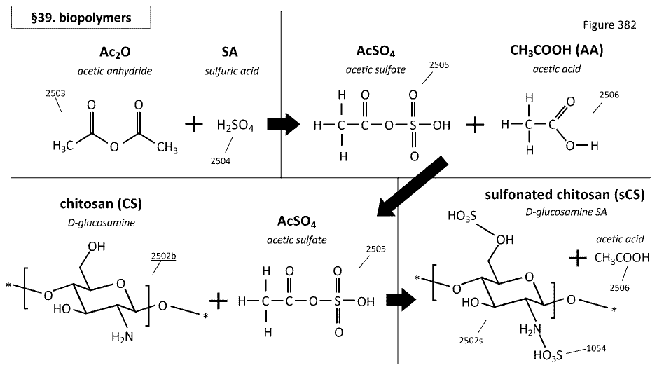

In its nascent form, chitosan is not an ionomer or an electrical conductor. Instead it must be functionalized by a acidic group to participate in ion exchange, either with protons in PEMs or anions in AEMs. For proton conduction two of the most significant acids are sulfonic acid and phosphoric acid. One process for sulfonating chitosan moiety 2502b is illustrated with acetic sulfate 2505 is shown in FIG. 382. Acetic sulfate (AcSO₄) 2505 is a mild sulfonating agent, less corrosive than concentrated sulfuric acid, but still providing a high degree of sulfonation. Formation of acetic sulfate (AcSO₄) 2505 starts with a reaction of acetyl anhydride (Ac₂O) 2503 with sulfuric acid (H₂SO₄) 2504.

As an alternative to sulfuric acid, acetyl sulfate (AcSO₄, C₂H₄O₅S) is a reagent able to sulfonate a variety of polymers at moderate temperatures with minimal reaction byproducts. Acetic anhydride (Ac₂O, (CH₃CO)₂O) 2503 is an isolable anhydride of a nonpolar carboxylic acid widely used in organic synthesis as a reagent. By combining it with the D-glucosamine moiety of chitosan (CS) 2502b, the chitosan becomes functionalized into an ionomer forming sulfonated chitosan (sCS) 2502s, aka D-glucosamine SA where sulfonic acid (SA) 1054 functions as an ionomer for proton conduction.

The reaction uses and also produces acetic acid (AcA, CH₃COOH) 2506 as both a reactant and a byproduct. Acetic acid, a weak monoprotic acid with the chemical formula CH₃COOH is a chemical reagent used in synthesis of vinyl acetate which can be polymerized into polyvinyl acetate or other polymers. Like ethanol and water, liquid acetic acid is a hydrophilic (polar) protic solvent able to dissolve polar compounds, inorganic salts, and sugars including chitosan. In one exemplary embodiment the sulfonation of chitosan employs acetyl sulfate as a sulfonating agent.

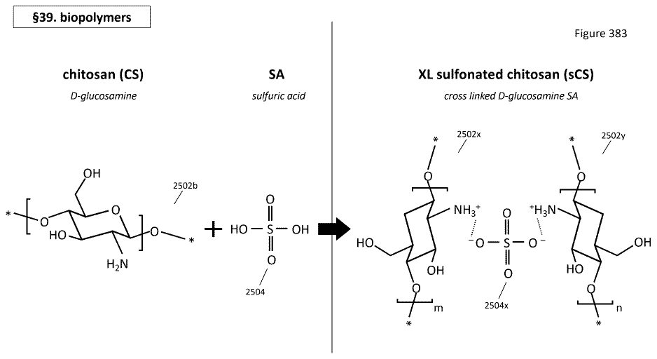

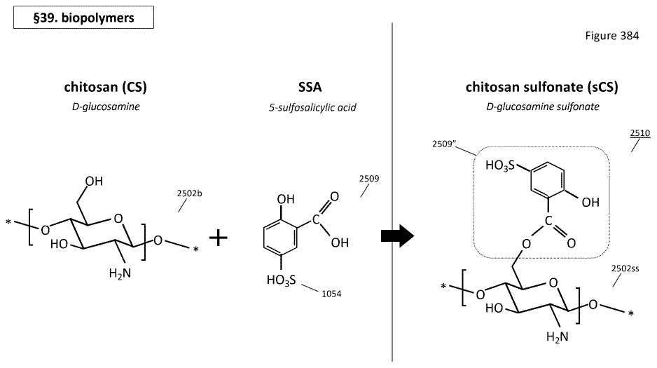

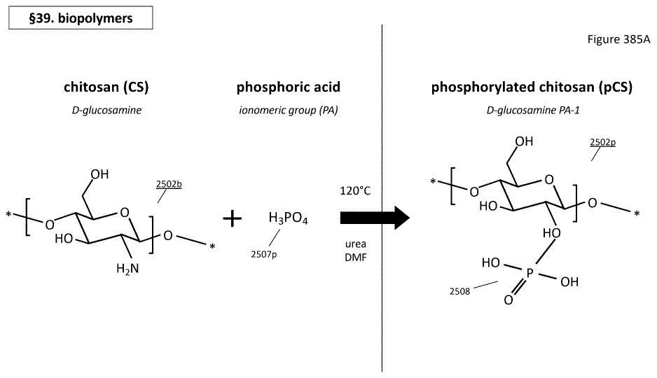

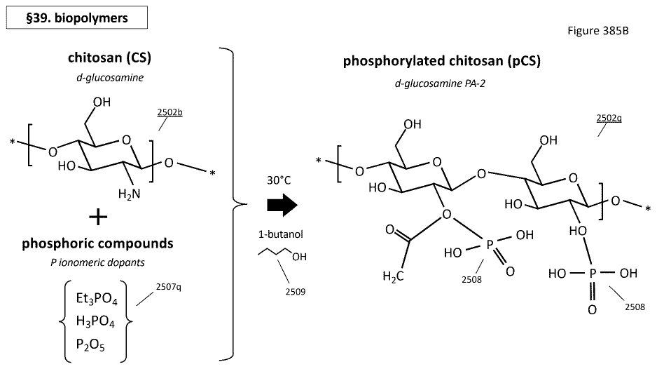

An alternative method to sulfonate chitosan involves cross linking using sulfuric acid (H₂SO₄). As shown in FIG. 383 the combination of chitosan (CS) moiety 2502b and sulfuric acid (H₂SO₄) 2504 creates an acidic cross-linking 2504x between chitosan mainchains 2502x and 3502y. Yet another method to sulfonate chitosan (CS) 2502 shown in FIG. 384 involves the application of 5-sulfosalicylic acid (SSA) 2509 with attached sulfonic acid group 1054. The resulting polymer D-glucosamine sulfonate or chitosan sulfonate (sCS) 2510 comprises the chitosan chain 2502ss with the attached sulfosalicylic group 2809. Such methods may include the use of heterogeneous catalysts on chitosan sulfonate based on an esterification reaction of oleic acid and methanol.

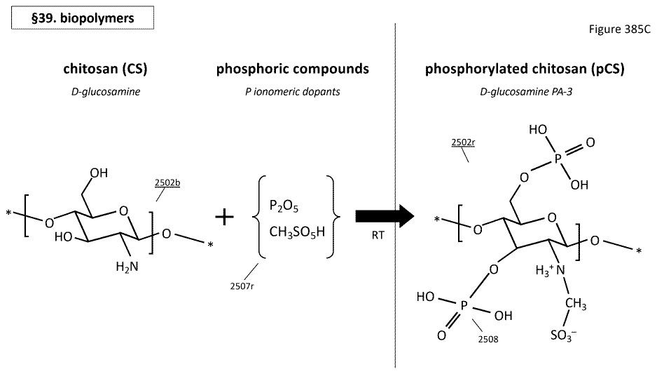

Chitosan can also be functionalized by phosphorylation. The chemical structure of phosphorylated chitosan or pCS is depicted in FIG. 385A, the treatment of chitosan moiety 2502b in phosphoric acid 2507p at 120° C. in urea (CO(NH₂)₂) a water soluble amide of carbamic acid and in DMF aka dimethylformamide, produces one variant of phosphorylated chitosan (pCS) 2502p, specifically D-glucosamine PA-1. In this reaction the NH₂ functional group is substituted by an OH group bonding to phosphoric acid (PA) 2508.

In a second variant shown in FIG. 385B, pristine chitosan (CS) is treated by a phosphorylating cocktail of ionomeric dopants 2507q comprising some blend of triethyl phosphate (Et₃PO₄), phosphoric acid (H₃PO₄), and phosphorus pentoxide (P₂O₅). Mixed at 30° C. with 1-butanol 2509, the combination results in another variant of phosphorylated chitosan (pCS) 2502q, specifically D-glucosamine PA-2 comprising two cyclic rings each with a corresponding phosphoric acid (PA) 2508 group.

In a third variant shown in FIG. 385C, a polymer of pristine chitosan 2502b is blended at room temperature (RT) with phosphoric compounds 2507r comprising phosphorus pentoxide (P₂O₅) and methane-sulfonic acid salt (CH₃SO₅H) to synthesize a third variant of phosphorylated chitosan (pCS) 2502r, specifically D-glucosamine PA-3 comprising a single cyclic ring, two phosphoric acid groups 2508, and a third group comprising a sidechain of an amino radical (NH₃), a methyl radical (CH₃), and a sulfonic acid group (SO₃H). Numerous other functionalized chitosan molecules exist, many of which are chemically reactive but limited in their ionic conduction capability.

Although functionalized chitosan and related polymers hold promise in future ionomeric membranes, they lack structural integrity and suffer from substandard conductivities. Aside from fragility, reliability, and low conductivity concerns, membranes constructed of chitosan can be improved significantly using inventive matter in this application. Remedies include (a) enhancing the film's mechanical strength by forming copolymers made in accordance with this invention, (b) enhancing the film's mechanical strength using the endoskeletal matrix and pillars made in accordance with this invention, (c) enhancing the porosity and electrical conductivity using the sacrificial filler made in accordance with this invention, and (d) increasing the ionomeric density by including protic ionic liquids or conductive dopants to enhance film conductivity.

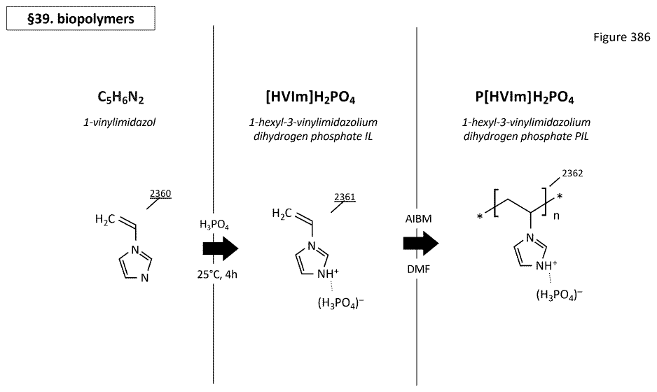

In regards to improving conductivity, FIG. 386 illustrates a process for forming a poly ionic liquid (PIL) where 1-vinylimidazol (C₅H₆N₂) 2360 is treated for 4 h at 25° C. in phosphoric acid (H₃PO₄) to produce 1-hexyl-3-vinylimidazolium dihydrogen phosphate ionic liquid ([HVIm]H₂PO₄) 2361. Subsequent reaction in azobisisobutyronitrile (AlBN) and dimethylformamide (DMF) results in the protic ionic liquid 1-hexyl-3-vinylimidazolium dihydrogen phosphate (P[HVIm]H₂PO₄) 2362. The PIL can then be introduced into the chitosan matrix to increase ionic density and enhance conductivity.

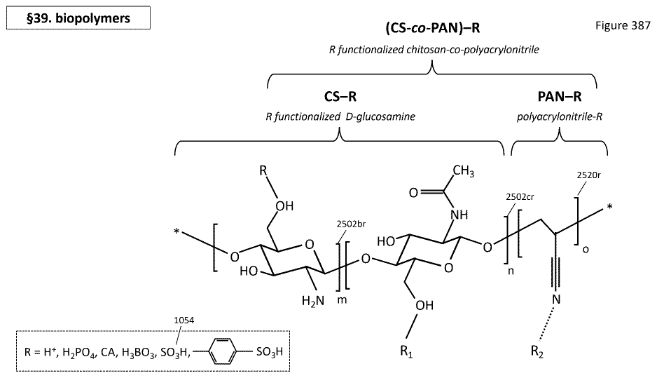

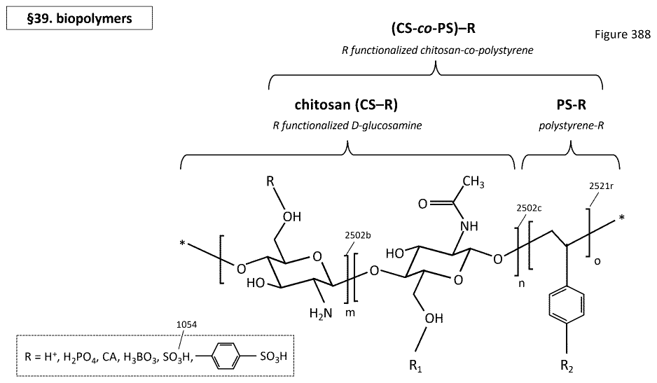

Chitosan forms copolymers with a variety of polymer types including polyacrylonitrile (PAN), polystyrene (PS), and polyvinyl alcohol (PVA). For example in FIG. 387, functionalized D-glucosamine moieties of chitosan (CS-R) 2502br and 2502cr form a linear chain copolymer with functionalized polyacrylonitrile R (PAN-R) 2520r, each with their respective radicals R₁ and R₂. The resulting copolymer, chitosan-co-polyacrylonitrile-R (CS-co-PAN-R) comprises two chitosan segments 2502br of length m and 2502cr of length n, and polyacrylonitrile 2520r of length o. The radicals R₁ and R₂ used to functionalized the chitosan and PAN segments may comprise hydrogen H⁺ usually in the form of hydronium ions (H₃O), phosphoric acid (H₂PO₄), citric acid (CA), bromic acid H₃BO₃, sulfonic acid (SO₃H); and benzenesulfonic acid (BzSA, BzSO₃H, C₆H₆O₃S).

In FIG. 388, chitosan moieties 2502br and 2502cr having functional groups R₁ and collectively referred to as functionalized chitosan (CS-R) or D-glucosamine R form a linear chain with functionalized polystyrene R (PS—R) 2521r. The resulting copolymer, chitosan-co-polystyrene-R (CS-co-PS—R) comprises two chitosan segments 2502br of length m and 2502cr of length n, and polyacrylonitrile of length o. The radicals R₁ and R₂ used to functionalized the chitosan and PAN segments may comprise hydrogen H⁺ usually in the form of hydronium ions (H₃O+), phosphoric acid (H₂PO₄), citric acid (CA), bromic acid H₃BO₃, sulfonic acid (SO₃H); and benzenesulfonic acid (BzSA, BzSO₃H, C₆H₆O₃S).

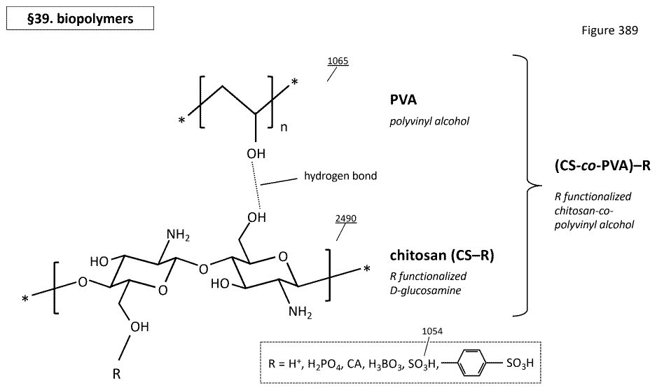

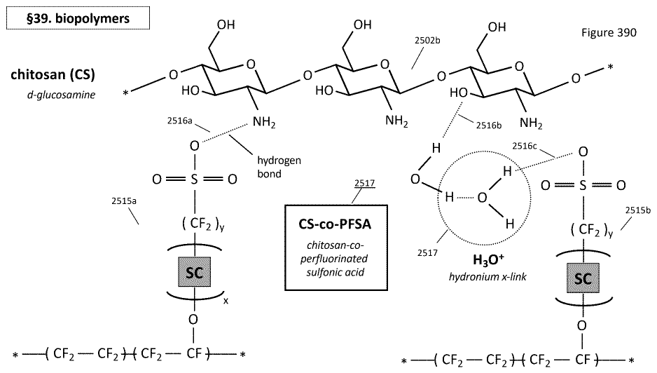

FIG. 389 illustrates the hydrogen bonding between polyvinyl alcohol (PVA) 1065 and functionalized chitosan (CS-R) 2490, i.e. comprising a copolymer CS-co-PVA, primarily used to form a polyvinyl alcohol-chitosan scaffold for tissue engineering and regenerative medicine application. Although the chemistry is intended for medical and drug applications, made in accordance with this invention the PVA-CS bond can be repurposed.

Another copolymer of chitosan shown in FIG. 390 comprises a copolymer of chitosan 2502b and perfluorinated sulfonic acid (PFSA) 2515a where a weak hydrogen bond 2516a between the sulfonic acid group of PFSA and the nitrogen of chitosan provides some, albeit limited, structural support to the matrix. Another bonding mechanism between PFSA 2515b and chitosan 2502b can independently occur through mobile hydronium ion 2517 comprising a chitosan-to-H₃O hydrogen bond 2515b and a separate H₃O⁺-to-PFSA hydrogen bond 2514c. Although none of the chitosan to PFSA bonds are covalent, some structural stability is achieved through a preponderance of the bonds throughout the blended polymer.

For this reason the film is not considered a copolymer but a blended polymer as denoted by the nomenclature CS-b-PFSA 2517. Its should be noted by only changing the atomic composition of sidechain SC, the pendant PFSA 1515a can be converted into a multi acid sidechain (MASC) such as perfluoro imide acid (PFIA). In such cases, the blended polymer is described as CS-b-PFIA.

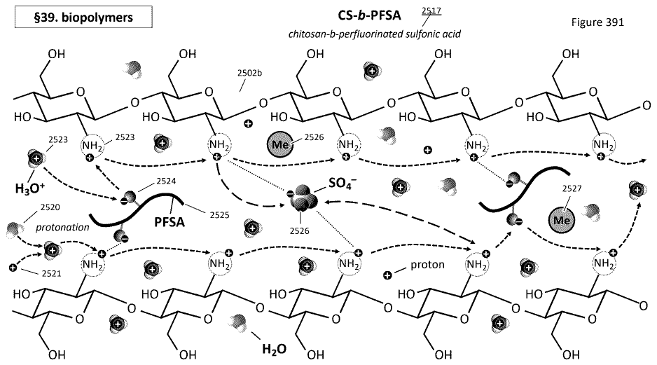

Conduction mechanisms within the CS-b-PFSA 2517 are depicted schematically in FIG. 391 where the matrix comprises multiple polymeric chains of chitosan 2502b with NH₂ functional groups 2523; polymeric chains of PFSA 2524 with ionomers 2524; and SO₄⁻ complexes held electrostatically through hydrogen bonds. As depicted proton 2521 protonates water 2523 to form hydronium ions 2523. Either protons 2521 or hydronium ions 2523 can conduct through the polymer electrolyte, hopping from NH₂ group 2523 to other NH₂ groups and occasionally traversing ionomer 2424 on PFSA 2525 or jumping via SO₄⁻ group 2526. Methane 2527 should not however cross the membrane. So even though PFSA 2525 and chitosan 2502b are not bonded they are still able to mutually cooperate in protonic conduction.

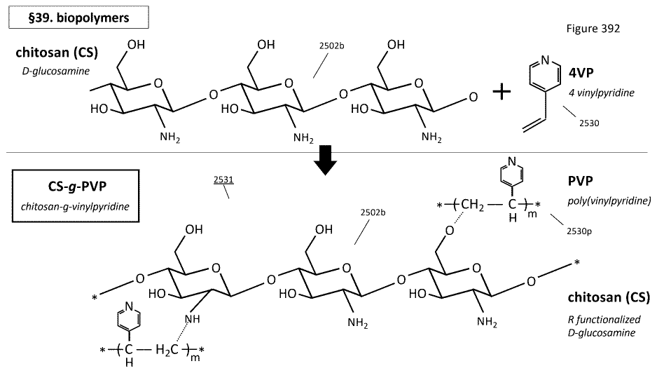

An exemplary process to form a grafted polymer of chitosan is shown in FIG. 392. In this cases the monomer 4-vinylpyridine (4VP) 2530 is grafted onto chitosan moiety D-glucosamine 2502b bonding onto either the hydroxide oxygen side group or the amine nitrogen. The resulting grafted polymer comprises chitosan-g-vinylpyridine (CS-g-PVP) 2531.

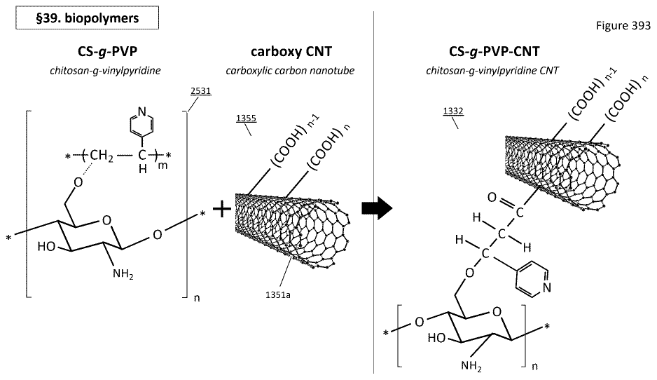

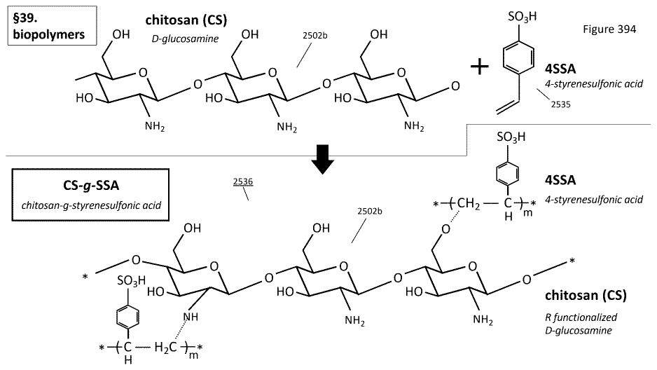

By combining chitosan-g-vinylpyridine (CS-g-PVP) 2531 with carboxylic carbon nanotube (carboxy CNT) 1355 produces chitosan-g-vinylpyridine CNT 1332 as shown in FIG. 393 produces a functionalized carbon nanotube dopant comprising chitosan-g-vinylpyridine CNT 1332. While this CNT is useful in filtration it is not functionalized for ionomeric conduction.

As an alternative made in accordance with this invention, a grafted polymer of chitosan shown in FIG. 394 grafts 4-styrenesulfonic acid (4SSA) 2535 onto chitosan moiety D-glucosamine (CS) 2502b bonding onto either the hydroxide oxygen side group or the amine nitrogen. The resulting grafted polymer comprises chitosan-g-styrenesulfonic acid (CS-g-SSA) 2536.

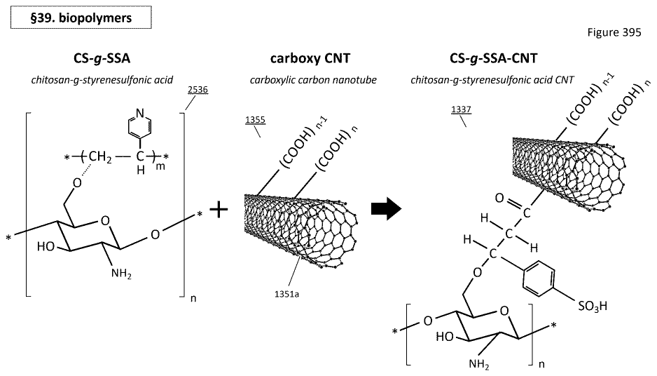

FIG. 395 illustrates by combining chitosan-g-styrenesulfonic acid (CS-g-SSA) 2536 with carboxylic carbon nanotube (carboxy CNT) 1355, a functionalized nanotube with ionomeric capability, specifically chitosan-g-styrenesulfonic acid CNT 2537 is synthesized. The resulting nanotube can be used as a permanent filler in any type of ionomeric membrane.

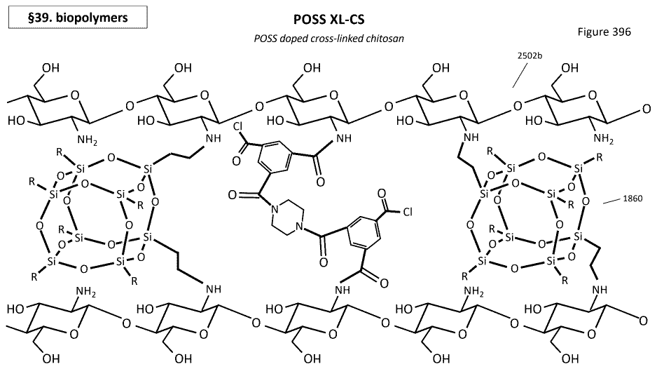

FIG. 396 illustrates the cross linking of two chitosan chains using POSS 1860 as the cross linking agent. Cross linking provides added structural support to the membrane while ionomeric or catalytic groups on the POSS enhance membrane performance.

Chitosan can also be modified to suppress fuel crossover in direct methanol fuel cells using acid-base amphoteric nanoparticles, for example comprising zwitterionic molecules of modified polydopamine. By participating in cross linking of chitosan, additional mechanical strength and durability can be conferred to a film. One possibility is to bond polydopamine (PDA) to a surfactant used in nanomaterial synthesis thereby bridging the polydopamine via a linear nanochain to a ionomeric terminus.

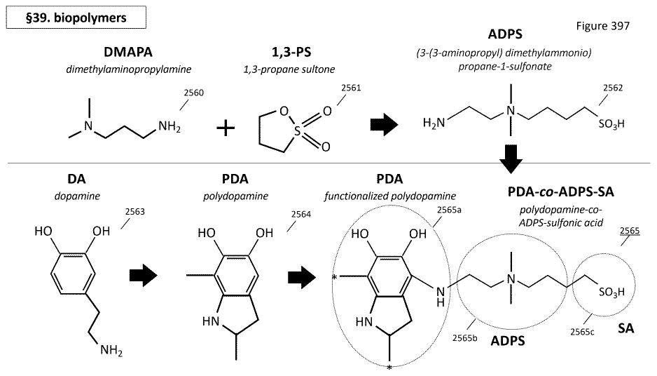

For example, as shown in FIG. 397, dimethylaminopropylamine (DMAPA) 2560 can be combined with 1,3-propane sulfone (1,3,PS) 2561 to form the zwitterionic nanofiller molecule (3-(3-aminopropyl) dimethylammonium) propane-1-sulfonate (ADPS) 2562 comprising both an amino and sulfonic acid termini. In parallel synthesis, dopamine 2563 is polymerized into polydopamine (PDA) 2564 then reacted with ADPS 2562 to form copolymer PDA-co-ADPS-SA 2565 comprising molecular segments polydopamine (PDA) 2565a; (3-(3-aminopropyl) dimethylammonium) propane-1-sulfonate (ADPS) 2565b, and sulfonic acid (SA) 2565c.

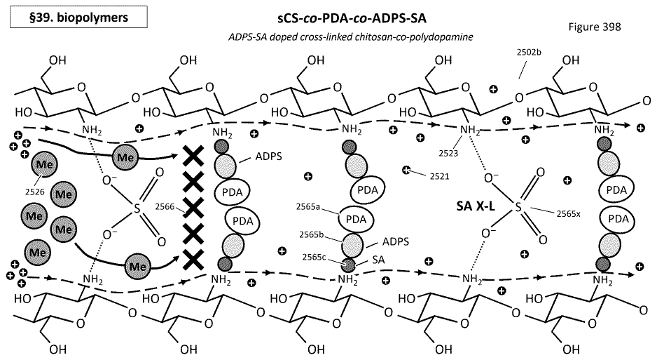

FIG. 398 illustrates PDA-co-ADPS-SA 2565 doping of a sulfonated chitosan (sCS) polymer matrix. Specifically polymer backbone CS 2502b with functional termini NH₂ 2523 form cross links to other chitosan chains through cross linking sulfonic acid group 2565x via oxygen-nitrogen bonds. Terminus SA 2565c of nanochain PDA-co-ADPS-SA 2565 also bonds to the chitosan nitrogen groups 2523 to form bridges blocking 2566 the porous channel between the CS chains. As such, methanol 2526 is unable to penetrate the membrane while proton 2521 hopping conduction occurs along the NH₂ 2523 ionomers unimpeded. Note because DMFC conduction is anhydrous, there is no significant presence of water or hydronium ions in the IEM.

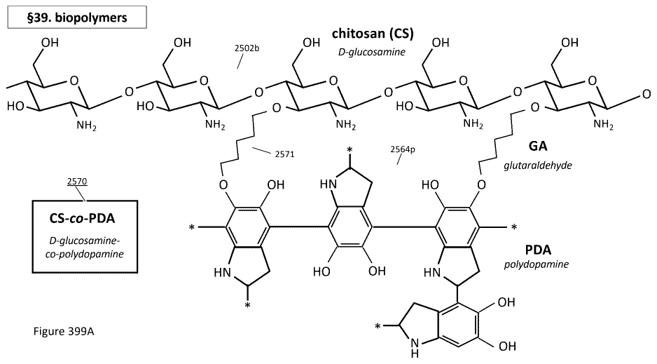

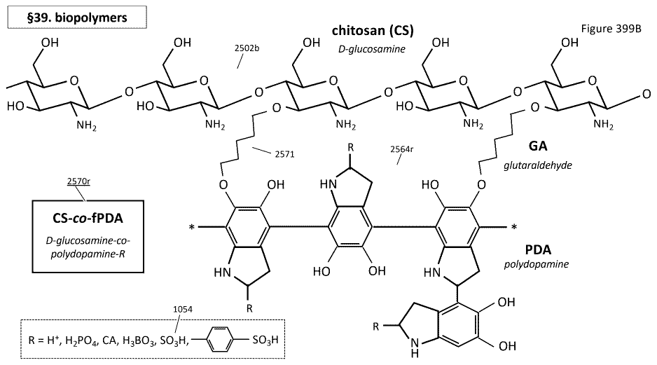

As shown in FIG. 399A, chitosan 2502b can also bond to polydopamine 2564 through the cross-linker glutaraldehyde (GA) 2571 to form the copolymer chitosan-co-polydopamine (CS-co-PDA) 2570. If the polydopamine is functionalized prior to polymerization by acids made in accordance with this invention, where the radical R contains hydrogen ions (H⁺) such as phosphoric acid (H₂PO₄), citric acid (CA), bromic acid (H₃BO₃), sulfonic acid (SO₃H) 1054, or benzenesulfonic acid (BzSA, BzSO₃H, C₆H₆O₃S), the resulting copolymer D-glucosamine-co-polydopamine-R (CS-co-fPDA) 2570r shown in FIG. 399B can function as an ionomer in ion exchange membranes, where the previously described non-functionalized copolymer CS-co-PDA 2570 cannot. Note that glutaraldehyde (GA) functions as a cross linker between the two polymer chains forming a carbon-to-oxygen bond to hydroxide groups on both polymers.

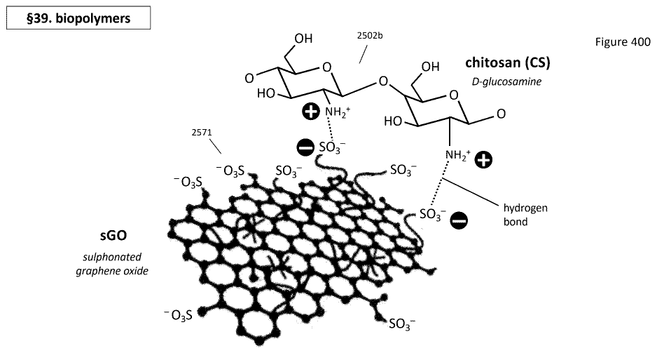

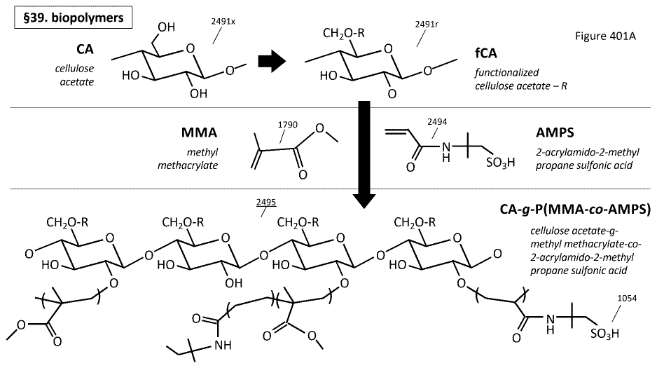

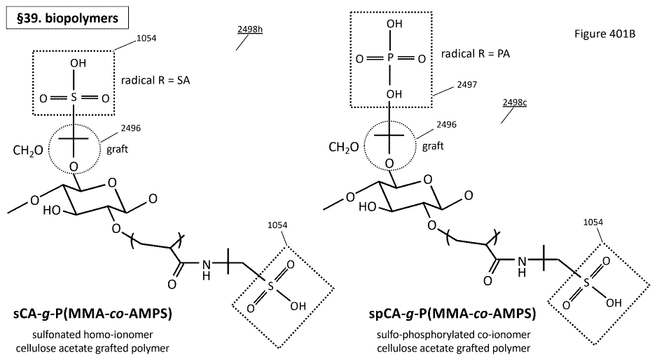

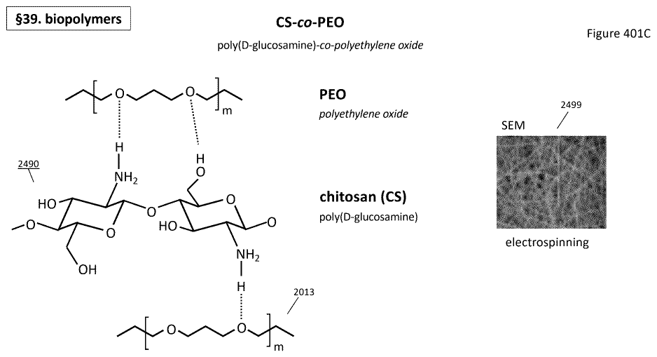

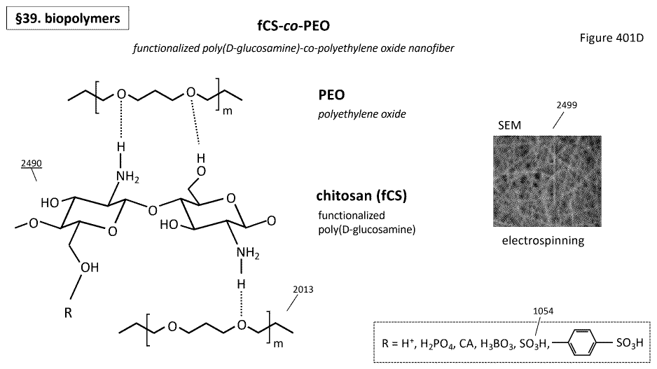

Chitosan can also be functionalized through introduction of covalently bonded permanent fillers into the polymer matrix. As shown in FIG. 400A, cellulose once converted into cellulose acetate (CA) 2491 can be modified into functionalized cellulose acetate (fCA) 2491r by a substitution reaction replacing the biopolymer's OH group with CH₂O—R containing an acidic radical R which made in accordance with this invention may contain hydrogen ions (H⁺) such as phosphoric acid (H₂PO₄), citric acid (CA), bromic acid (H₃BO₃), sulfonic acid (SO₃H) 1054, or benzenesulfonic acid (BzSA, BzSO₃H, C₆H₆O₃S). Subsequent treatment in methyl methacrylate (MMA) 1790 and 2-acrylamido-2-methyl propane sulfonic acid (AMPS) 2494 results in the copolymer cellulose acetate-g-methyl methacrylate-co-2-acrylamido-2-methyl propane sulfonic acid (CA-g-P(MMA-co-AMPS) 2495.

Made in accordance with this invention, depending on the choice of radical R the molecule can be modified to contain a single species of ionomer such as sulfonic acid or co-ionomers comprising two acids such as sulfonic and phosphoric acid. For example FIG. 400B illustrates two modifications to grafted copolymer CA-g-P(MMA-co-AMPS) 2495. For simplicities sake, only the rightmost cellulose aromatic ring and its attached groups are depicted. In the homo-ionomer moiety 2498h comprising sulfonated cellulose acetate grafted copolymer (sCA-g-P(MMA-co-AMPS)), radical R comprises sulfonic acid (SA, SO₃H) 1054. Including the second instance of SA 1054 associated with the AMPS side group, the segment includes two ionomers of the same chemical composition and reactivity. This molecule exhibits a higher conductivity than is cases where radical R is substituted by a non acidic group such as ethanol, hydroxide, or an amine group.

By contrast in the co-ionomer moiety 2498c of sulfonated-phosphorylated cellulose acetate grafted copolymer (spCA-g-P(MMA-co-AMPS)), radical R comprises phosphoric acid (PA, H₂PO₄) 2497. Including the sulfonic acid 1054 associated with the AMPS side group, the segment includes two ionomers of the differing chemical composition and reactivity—one involving sulfonic acid, the other comprising phosphoric acid.

The combination of two different ionomers, both capable of proton conduction offers redundancy in conduction mechanisms not available from IEMs with homo-ionomeric groups. By incorporating both sulfonic and phosphoric acid groups into a proton exchange membrane (PEM) as ionomers, numerous unexpected benefits are manifest. These benefits include improved conductivity, enhanced operating range of temperature range over varying conditions of humidity, temperature, and pH; greater film durability; and longer use life. The benefit of the dual-acid co-ionomer membrane is not limited to biopolymers but applies to all polymers and copolymers, details which will be enumerated later in this application.

FIG. 401A illustrates a nanofiber 2499 formed by electrospinning a copolymer of chitosan 2490 and polyethylene oxide (PEO) 2013 results in chitosan-co-polyethylene oxide (CS-co-PEO). Although the fibrous material has medical applications, it is not conductive or useful in IEMs. Made in accordance with this invention, by functionalizing chitosan 2490r before copolymerization with a radical R containing hydrogen ions (H⁺) such as phosphoric acid (H₂PO₄), citric acid (CA), bromic acid (H₃BO₃), sulfonic acid (SO₃H) 1054, or benzenesulfonic acid (BzSA, BzSO₃H, C₆H₆O₃S), the resulting functionalized copolymer fCS-co-PEO can be converted into nanofibers as a permanent filler for chitosan membranes as shown in FIG. 401B.

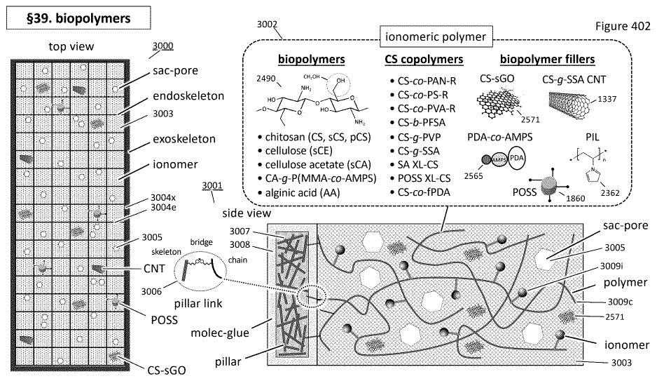

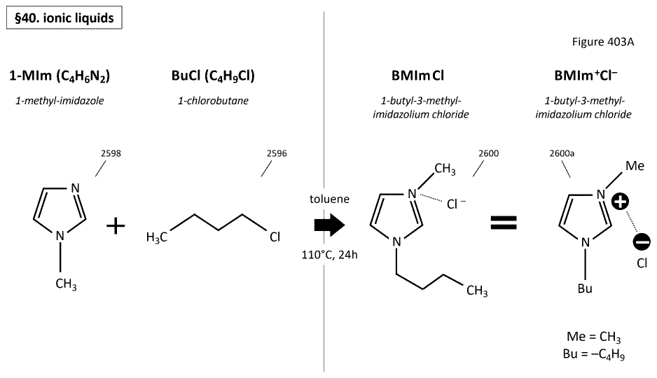

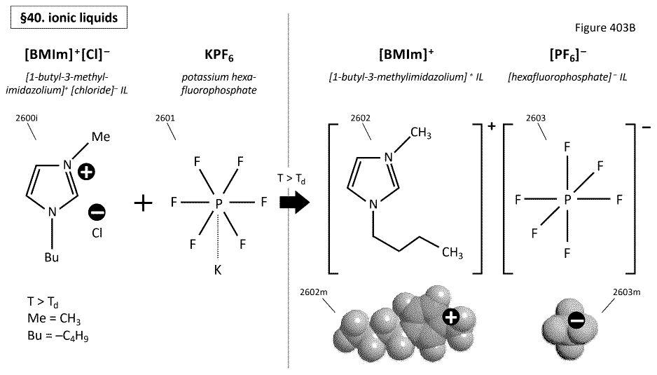

In summary, membrane top view 3000 and membrane side view 3001 in FIG. 402 illustrate a variety of elements of polymer 3002 comprising biopolymers such as chitosan, cellulose, cellulose acetate, or alginic acid made in accordance with this invention, including:
an ion exchange membrane 3003 composed of one or more polymeric backbone chains 3009c including ionomers 3009i present along the backbone chains or connected to the mainchain via a pendant sidechain; and/or
a semi-rigid network of pillars comprising a wide exoskeleton 3004x and a grid pattern of a thinner endoskeleton 3004e, where the exoskeleton shown in top view 3003 may be cut mechanically or cut by laser to singulate the membrane from other membranes fabricated in the same film sheet;
where the pillars comprise a reinforced core 3007 containing carbon fiber or plastic shards optionally surrounded by adhesive or molecular glue 3008;
where the polymer chain 3009c is chemically attached to pillar's core 3007 by pillar link 3006 which may include adhesive or molecular glue 3008 to facilitate attachment;
where the pillars form a skeletal structure circumscribing multiple panes of membrane 3003 providing mechanical support and limiting membrane 3003 deformation due to water absorption or dehydration;
where membrane 2003 may include sac-pores 3005 interrupting the lattice periodicity of membrane 3003 by the previous introduction of a sacrificial filler prior to molding and its subsequent removal post casting by a solvent leaving a hole in its place of the sac-filler; and/or
where an optional nanocoating (not shown) is formed atop membrane 3003 to either enhance membrane conductivity, increase the rate of oxygen reduction reactions (ORR) in the cathode, or provide protection against membrane poisoning including boron nitride or other materials that inhibit the diffusion of carbon monoxide (CO) into the catalyst layer;
where ionomeric polymer 3002 may comprise the biopolymers such as chitosan (CS) 2490, cellulose (CE) 2491, cellulose acetate (CA) 2491x, or alginic acid 2492 as a mainchain, optionally blended or cross linked though crosslinking ionomer 1009x to other polymer chains or to dissimilar homopolymers, heteropolymers, copolymers, such as polyacrylonitrile (PAN) 2520r, polystyrene (PS) 2521r, polyvinyl alcohol (PVA) 1065, perfluorinated sulfonic acid (PFSA) 2515a or 2515b, PFIA (not shown but similar to PFSA), vinylpyridine (PVP) 2530p, polydopamine (PDA) 2564p, polydopamine-co-(3-(3-aminopropyl) dimethyl-ammonium) propane-1-sulfonate (PDA-co-AMPS) 2565, or grafted to cellulose acetate-g-methyl methacrylate-co-2-acrylamido-2-methyl propane sulfonic acid (CA-g-P(MMA-co-AMPS) 1495, thereby controlling varying degrees of film crystallinity and anisotropy;
where ionomeric polymer 3002 may comprise sidechains serving as pendants and influencing crystalline regularity, porosity, conductivity, and fuel crossover of the membrane where the pendants and/or ionomers may also serve to perform crosslinking among chains;
where ionomeric polymer 3002 may comprise an ionomer 3009i or crosslinking ionomer of reactive sulfonic acid groups —SO₃H, sulfosuccinic acid groups C₄H₆O₇S, carboxylic acid groups —COOH, phosphoric acid groups —PO₃H₂, phosphorous acid PO₄H₂, phosphotungstic acid (PWA), imide groups —CONH, quaternary ammonium groups —NR₃⁺, pyridinium groups —C₅H₅N⁺, imidazolium groups —C₃H₃N₂⁺; tetraalkylammonium groups —NR4⁺; phenolic hydroxyl groups —OH, trimethoxysilylpropanethiol (TMSP), or any other acidic group which easily ionizes to donate conducting cations of H⁺, Na⁺, or K⁺ into the solid electrolyte; and finally
where the combination of the endoskeletal pillars and the membrane coating are used to seal in any ionic liquid doping to prevent seepage, leakage, or IL depletion.

The below table summarizes various structures, ionomers, endoskeletons, solvents, cross-linkers, and fillers used to synthesize biopolymer membranes made in accordance with this invention comprising a heterogenous membrane of biopolymers such as chitosan homopolymers and heteropolymers with a variety of sidechains, grafts, and copolymers.

As listed below, biopolymers of chitosan (CS), cellulose (CE), cellulose acetate (CA), and alginic acid (AA), and variants thereof include sulfonated ionomers such as sCS, sCE, sCA, and sAA; along with phosphorylated ionomers such as pCS, pCE, pCA, and pAA. Functionalized chitosan copolymers and grafts include polyacrylonitrile (sCS-co-PAN-R), polystyrene (sCS-co-PS—R), polyvinyl alcohol (sCS-co-PVA-R), perfluorinated sulfonic acid (CS-co-PFSA, sCS-co-PFSA), vinylpyridine (sCS-g-PVP), sulfosuccinic acid (CS-g-SSA), polydopamine (CS-co-fPDA), and polydopamine-co-(3-(3-aminopropyl) dimethyl-ammonio) propane-1-sulfonate (PDA-co-AMPS). Cross-linked chitosan-to-chitosan chains include POSS, sulfonic acid (SA), phosphoric acid (PA), glutaraldehyde (GA), and sulfonated glutaraldehyde (sGA).

Exemplary cellulose grafts include cellulose acetate-g-methyl methacrylate-co-2-acrylamido-2-methyl propane sulfonic acid (CA-g-P(MMA-co-AMPS). Permanent fillers and dopants include sulfonated or phosphorylated graphene oxide (sGO, pGO), chitosan grafted styrenesulfonic acid coated carbon nanotubes (CS-g-SSA-CNT), protic ionic liquids (PIL), polydopamine-co-ADPS-sulfonic acid nanochains (PDA-co-ADPS-SA NCs) and polyoctahedral silsesquioxanes (POSS).

| ionomer | structure | endoskeleton | solvents, X-L | fillers |
|---|---|---|---|---|
| §39. chitosan | biopolymers | chitosan polymers: | solv: HCl, AcOH, | biopolymer filler: |
| sulfonated (sCS) | chitosan | alginate, PAA, PEG, | L-AA, HCOOH, L- | sCS-GO, pCS-GO, |
| phosphorylated (pCS) | cellulose | syn polypeptides | Gu, lacOH, SuA, | CS-g-SSA CNT, |
| sCS-co-PAN-R | cellulose | cellulose polymers: | malOH, MA, PA | CS-PEO nanofiber, |
| sCS-co-PS-R | acetate | PVA, PEG-PEO, | X-L: PA, SA, GA, | P[HVIm] H₂PO₄ PIL, |
| sCS-co-PVA-R | alginic acid | PEG, PLA | sGA, POSS, SO₄⁻, | POSS X-L, PDA-co- |
| CS-co-PFSA | | pillar: | ECH | AMPS nano-chain |
| sCS-b-PFSA | | reinforcing fillers | | other fillers: |
| sCS-g-PVP | | (C-fiber, CNTs) | | sac filler, CNTs, |
| CS-g-SSA | | | | oxides, POSS, |
| SA XL-CS | | | | NPs, MOFs, PIL |
| POSS XL-sCS | | | | |
| CS-co-fPDA | | | | |
| §39. other biopolymers | | | | |
| cellulose (sCE) | | | | |
| cellulose acetate (sCA, | | | | |
| pCA, spCA) | | | | |
| CA-g-P(MMA-co-AMPS) | | | | |
| alginic acid (AA) | | | | |

Made in accordance with this invention, a variety of endoskeletal support able to bond to biopolymer membranes include chitosan and cellulose compatible pillars. Chitosan compatible pillars include alginate able to form ionic bonds between its carboxylate groups and chitosan's amino groups; polyacrylic acid (PAA) able to form hydrogen bonds with chitosan within a proper range of pH; polyethylene glycol (PEG) able to form hydrogen bond between both hydroxyl and amino groups of chitosan; as well as various synthetic polypeptides containing carboxylic acid groups forming ionic bonds with the amino groups of chitosan.

A number of polymeric pillars can also bond to cellulose membranes. They include polyvinyl alcohol (PVA) and polyethylene oxide (PEO) able to form strong hydrogen bonds with the hydroxyl groups of cellulose; poly(methyl methacrylate) (PMMA) which when properly modified can form hydrogen bonds to CE; polyethylene glycol (PEG) and to a lesser extent polylactic acid (PLA) both of which can form hydrogen bonds to cellulose.

Solvents able to dissolve or modify the surface of chitosan include hydrochloric acid (HCl), acetic acid (AcOH, HAc), L-ascorbic acid (L-AA), formic acid (HCOOH), L-glutamic acid (L-Gu), lactic acid (LacOH), maleic acid (malOH), malic acid (MA), phosphorous acid (PA), and succinic acid (SuA). Solvents for cellulose include polyvinyl alcohol (PVA), polyethylene glycol (PEG), poly(methyl methacrylate) (PMMA), and polylactic acid (PLA). Cross linkers include phosphoric acid (PA), sulfonic acid (SA), glutaraldehyde (GA), sulfonated glutaraldehyde (sGA), cross linking polyoctahedral silsesquioxanes (X-L) POSS), sulfate anion group (SO₄⁻), and epichlorohydrin (ECH).

Biopolymer fillers include sulfonated and phosphorylated graphene oxides (sCS-GO, pCS-GO), sulfosalicylic acid carbon nanotubes (CS-g-SSA CNTs), chitosan polyethylene oxide (CS-PEO) nanofibers, protic ionic liquids such as P[HVIm]H₂PO₄ PIL, cross linking POSS X-L, and nanochain PDA-co-AMPS. Other membranes fillers and dopants were described previously and for brevity's sake, will not be repeated here.

### § 40. Ionic Liquid (IL) IEMs.

An ionic liquid is liquid phase organic salt comprising an organic cation or proton paired with an organic or inorganic anion. Unlike ordinary liquids which such as water and fossil fuels which comprise mostly of electrically neutral molecules, an ionic liquid is derived from positively and negatively charged radicals which remain ionically bonded below a certain melting temperature and dissociate from one another above its melting point. To be considered a ionic liquid the ionic molecule's dissociation temperature generally occurs below 100° C.

For clarity's sake, below its decomposition temperature T_{d} of an ionic liquid shall be referred as an ionic salt IS comprising its bonded constituent cations IS_{c} and anions ISₐ together forming the net neutral molecular structure IS_{c}ISₐ. Above its dissociation temperature T_{d}, the charged radicals separate forming free-floating radicals comprising the ionic liquid's cation [IL_{c}]⁺ and the ionic liquid's anion [ILₐ]⁻. As such, dissociation of an ionic salt to form an ionic liquid [IL] is governed by the dissociation reaction above the dissociation temperature T_{d} given by

$${IS}_{c} {IS}_{a} ⇒ {[ {IL}_{c} ]}^{+} + {[ {IL}_{a} ]}^{-} for T > {T}_{d}$$

where the bracketed components indicate the ionic molecule has been ionized from its ionic salt IS_{c}ISₐ into its constituent ionic components [IL_{c}]⁺ and [ILₐ]⁻. Once dissociated, the charged radicals float in solution and do not recombine. In the case of ionic liquids, the term dissociation temperature T_{d} can generally be construed as synonymous with melting temperature Tₘ, meaning the solid salt goes into solution.

Unlike conventional fluids an ionic liquid behaves as a viscous solution similar to compressed fluids even when not under pressure. In general, ionic liquids exhibit solubility in both polar and non-polar liquids, depending on the nature of the ionic liquid and the solvent. Due to strong ionic interactions between an IL and a polar solvent's molecules, ionic liquids are quite soluble in a wide range of polar solvents such as water, methanol, and ethanol. Ionic liquids also may dissolve in non-polar solvents like hexane, toluene, or chloroform where the bonding occurs via non-polar or weakly polar groups within the solution. The solubility of ionic liquids in various solvents strongly depends on the specific cation and anion comprising the ionic liquid. For example, ionic liquids with long alkyl chains may have increased solubility in non-polar solvents, while those with more hydrophilic groups are more soluble in polar solvents.

The influence of an ionic liquid on conduction in an ion exchange membrane depends on the carrier type of the film. Although and IL contribute both cations and anions to an electrolyte, only one of the two species significantly affects membrane conductivity. Specifically an ionic liquid affects the conductivity of a proton exchange layer by action of its cationic radicals [IL_{c}]⁺. Conversely, the presence of the ionic liquid anion [ILₐ]⁻ has little or no influence on conductance of a proton exchange membrane.

### Types of Ionic Liquids.

Ionic liquids comprise a broad spectrum of chemical compounds addressing diverse applications. Examples include chiral ionic liquids (CILs) used as solvents and catalysts; switchable polarity solvent ionic liquids (SPS-ILs) used in solvent recovery and solute separation; bio-ionic liquids (Bio-ILs) used in biodiesel, renewable fuel, and chemical compound production; and energetic ionic liquids used in propellants and explosives. Other ionic liquids include neutral ionic liquid (N-ILs) as solvent; metallic ionic liquids (M-ILs) for catalysts, solvents, organometallic hydration, and waste recycling; basic ionic liquids (B-ILs) providing eco-friendly catalysts, solvents, and chemical base substitutes; and supported ionic liquids (S-ILs) for solvent, catalyst, and separation processes.

Ionic liquids commonly used in electrochemical applications such as batteries, fuel cells, hydrolysis, and super capacitors are primarily categorized into three classes, namely:
Protic ionic liquids (PILs)—ionic liquids comprising cations having N—H bonds able to easily ionize at room temperature donating free protons to a membrane or electrolyte. Examples of PILs include imidazolium [C₃H₅NH₂]⁺, pyridinium [C₅H₅NH]⁺, ammonium [NH₄]⁺, ethanolammonium ([C₂H₅NH₃]⁺, diethanolammonium [C₄H₁₁NO₂]⁺, triethanolammonium [C₆H₁₅NO₃]⁺, tetramethylammonium [C₄H₁₂N]⁺, diethylmethylammonium [DEMA]⁺, piperidinium [C₅H₁₂N]⁺, morpholinium [C₄H₁₀NO]⁺, and quinuclidinium [C₇H₁₄N]⁺ cations;
Aprotic ionic liquids (AILs)—ionic liquids comprising cations lacking N—H bonds. Examples of AILs include cations comprising 1-butyl-3-methylimidazolium [BuMeIm]⁺, 1-ethyl-3-methylimidazolium [EMeIm]⁺, 1-hexyl-3-methylimidazolium [HMeIm]⁺, 1-octyl-3-methyl imidazolium [OMeIm]⁺, 1-butyl-1-methylpyrrolidinium ([BuMePyrr]⁺, 1-ethyl-1-methyl pyrrolidinium [EtMePy]⁺, 1-butyl-1-methylpiperidinium [BuMePip]⁺, 1-ethyl-1-methyl piperidinium [EtMePip]⁺, tetraethylammonium [TEtA]⁺, and tetrapropylammonium [TPA]⁺, and quaternary ammonium [NR₄]⁺; and,
Polymerized ionic liquids (PolyILs)—ionic liquids comprising a polyelectrolyte where ionic groups are connected through a polymeric backbone. Examples of poly ILs include vinyl copolymers of imidazolium such as poly(1-butyl-3-vinylimidazolium) [Poly(BuVIm)]⁺, poly(1-ethyl-3-vinylimidazolium) [Poly(EtVIm)]⁺, poly(1-hexyl-3-vinylimidazolium) [Poly(HVIm)]⁺, and poly(1-octyl-3-vinylimidazolium) [Poly(OVIm)]⁺. Other PolyILs include vinyl copolymers of pyrrolidinium such as poly(1-butyl-1-vinylpyrrolidinium) [Poly(BuVPyrr)]⁺ and poly(1-ethyl-1-vinylpyrrolidinium) [Poly[EtVPyrr]⁺. Other vinyl copolymers comprise poly(1-butyl-1-vinylpiperidinium) [Poly(BuVPip)]⁺ and poly(1-ethyl-1-vinylpiperidinium) [Poly(EtVPip)]⁺.

Although protic, aprotic, and polymerized ionic liquids are considered as preferred ILs for improving ion exchange membrane performance, the other types of membranes listed may also used.

### Ionic Liquid Synthesis.

Synthesis of an ionic liquid generally involves substituting a positively charged group onto a neutral organic molecule then complexing it with a negatively charged molecule to form a weakly bonded ionic pair. To minimize bond strength, one charged radical generally the cation is generally significantly larger and having a higher molecular weight than its oppositive charged counterpart. The first reported synthesis of a ionic liquid occurred in 1914 by Von P Walden in the journal Bulletin de l'Académie Imperiale des Sciences de St Pétersburg describing a process neutralizing ethylamine with concentrated nitric acid to form ethylammonium nitrate [EtNH₃]⁺[NO₃]⁻ exhibiting a ion dissociation temperature, i.e. melting point (mp) of 13° C. The author discusses a number of unique characteristics of low temperature ammonium salts described as ‘molten salts’ stating “Anhydrous salts were chosen, which melt at relatively low temperatures, approximately up to 100° C. These low melting points limited the degree of thermolysis of both the solvent and the dissolved salts in the molten salt. Therefore, they allowed for the reproducibility of the observation of melts of anhydrous mineral salts at low temperatures previously only feasible at high temperatures.”

Processes used to form ionic liquids can be divided into two categories—primary IL synthesis and secondary IL synthesis. In primary synthesis, non-ionic organic and inorganic reactants, i.e. reactants that are not especially electropositive or electronegative are combined to form a new compounds or molecules that behave as radicals with monovalent, divalent, and sometimes trivalent charge. In secondary IL synthesis, a primary ionic liquid is further modified into a different ionic liquid either by modifying the IL cation, IL anion, or both in order to modify the chemical, electrical, thermal, or material properties of the original primary IL.

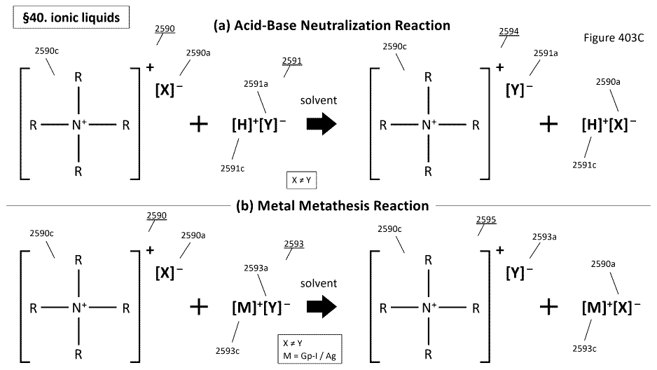

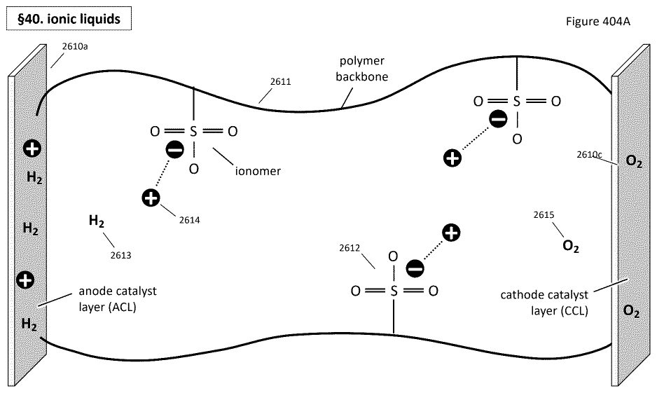

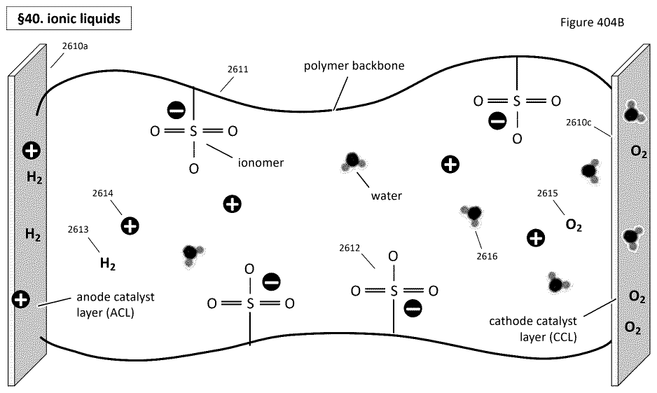

FIG. 403A illustrates a primary IL synthesis process whereby the aromatic 1-methyl-imidazole (1-MIm) 2598 having a molecular formula C₄H₆N₂ is reacted with 1-chlorobutane (BuCl) with a molecular formula C₄H₉Cl in the presence of the solvent toluene at 110° C. for 24 h to form the ionic salt 1-butyl-3-methyl-imidazolium chloride BuMeIm⁺Cl⁻ 2600. The same molecule can be represented in simplified version 2600a as an organic salt by substituting CH₃ with the abbreviation Me for a methyl group and by replacing —C₄H₉ with the butane abbreviation ‘Bu’.

Above its dissociation temperature T>T_{d} the ionic salt 2600a can be depicted as a primary ionic liquid 2600i by removing the hydrogen bond shown previously as a dotted line from the molecule as depicted in FIG. 403B. Chemically the ionic liquid is denoted by placing square brackets around its cation and anion components. For example the ionic salt notation BuMeImCl or (BuMeIm⁺Cl⁻) 2600 becomes the organic liquid [BuMeIm]⁺[Cl]⁻ 2600i.

It should be noted that in some publications simpler abbreviations for constituent organic molecules are used thereby shortening the compound's acronym but adding ambiguity into its meaning. Except when referring to a specific reference in this application the organic radical butyl is abbreviated as Bu rather than B since the single letter abbreviation can be misconstrued to mean elemental boron. Similarly, a methyl group is abbreviated herein as Me to avoid confusion with the capitalized letter M which may refer to a metal atom, ion, crystal, or cluster. Especially problematic is abbreviating radicals capitalized letter E as it can be easily misinterpreted among several candidate meanings. Instead herein Et is used for ethyl, Eth is used for ethanol, and PE for polyester. A solitary capitalized letter E is thereby preserved to mean energy.

Some acronyms are less ambiguous when considered in context to the topic being discussed primarily because they do not appear together in the same discussion. For example, a capitalized letter V has three meanings—the element vanadium, the electrical parameter voltage, and to represent spatial volume of an object or container. Similarly the letter R may refer to a chemical radical R or to electrical resistance.

Organic liquids can also be converted from one to another affecting material properties without affecting an IEM's electrochemistry. For IL doping of a proton exchange membrane, the electrochemically inactive anion can be substituted without substantially affecting conduction so long that the IL cation remains the unchanged. As shown by combining organic salt 2600 or organic liquid 2600i with potassium hexafluorophosphate (KPF₆) 2601 the chlorine anion [Cl]⁻ is displaced from the organic liquid [BuMeIm]⁺[Cl]⁻ 2600i while concurrently the potassium cation [K]⁺ is displaced from potassium hexafluorophosphate 2601.

Above its melting point at −8° C., the resulting ionic salt dissolves into an ionic liquid comprising positively-charged cation [1-butyl-3-methylimidazolium]⁺ 2602 abbreviated as [BuMIm]⁺ with molecular structure 1602m and negatively-charged anion [hexafluorophosphate]⁻ 2603 or [PF₆]⁻ with molecular structure 1603m. Despite both being monovalent, the size of the positively charged cation 2602m having an appearance of a sprig of grapes is significantly larger than anion 2603m. These molecular images are subsequently used to illustrate the role of IL dopants in membrane conduction mechanisms.

Referring again to FIG. 403B, a secondary transformation can be achieved by substituting the chloride radical in the ionic liquid [BuMeIm]⁺[Cl]⁻ 2600i with tetrafluoroborate [BF₄]⁻ to form a secondary ionic liquid [BuMeIm]⁺[BF₄]⁻. In this process, finely powdered 1-butyl-3-methylimidazolium chloride is first reacted with potassium tetrafluoroborate in distilled water stirring it till it becomes a homogenous solution. Thereafter excess water is removed under low pressure of 0.1 bar at 80° C. The suspension is then dissolved in the solvent dichloromethane and anhydrous magnesium sulfate, and left standing 1 h before filtering to produce the salt methylimidazolium tetrafluoroborate which melts at room temperature into the ionic liquid [BuMIm]⁺[BF₄]⁻ (not shown).

In a related process variant, the chloride radical in the ionic liquid [BuMIm]⁺[Cl]⁻ 2600i is replaced with a nitrate group [NO₃]⁻ without changing its imidazole cation. Specifically the ionic salt 1-butyl-3-methylimidazolium chloride (BuMeIm⁺Cl⁻) is treated at room temperature for 24 h by silver nitrate (AgNO₃) thereby converting the salt into the ionic liquid 1-butyl-3-methylimidazolium nitrate [BuMeIm]⁺[NO₃]⁻ (not shown).

As represented in FIG. 403C, the processes used in secondary synthesis of ionic liquids can be generalized into two prevalent reaction types—acid-base neutralization reactions and metal metathesis reactions. In a secondary IL synthesis process utilizing acid-base neutralization reaction (a) as shown, an ionic liquid 2590 comprising organic cation 2590c and anion 2590a are reacted with a ionic salt 2591 containing cation 2591c and anion 2591a dissolved in a compatible solvent. Depending on the reaction kinetics and Gibbs free energy of the reactants and products, i.e. the thermodynamics of the reaction, the cation and anions of the reactants are swapped resulting in a secondary ionic liquid 2594 comprising organic cation 2590c and anion 2591a. A waste salt of cation 2591c and anion 2590a is subsequently removed as a solute by filtering. Aside from thermodynamic constraints the reaction is only limited such that the species of anions 2590a and 2591a must differ, i.e. [X]⁺≠[Y]⁺.

In another secondary IL synthesis process baaed on metal metathesis reaction (b) as identified, an ionic liquid 2590 comprising organic cation 2590c and anion 2590a are reacted with a metallic salt 2593 containing metal cation 2593c and anion 2593a dissolved in a compatible solvent. Metal cation 2593c may comprise a transition metal, typically of silver (Ag), or alternatively comprising am an element from Group-I of the periodic table. Depending on thermodynamics, the cation and anions of the reactants are swapped resulting in a secondary ionic liquid 2595 comprising organic cation 2590c and anion 2591a. A waste salt of metallic cation 2593c and anion 2590a is subsequently removed as a solute by filtering. As described the metallic cation is a waste product which can be reclaimed and used again improving the environmental sustainability of the secondary IL synthesis process. As in the prior acid-base IL reaction, the species of anions 2590a and 2591a must differ, i.e. [X]⁺≠[Y]⁺.

### Conduction in Ionic Liquids.

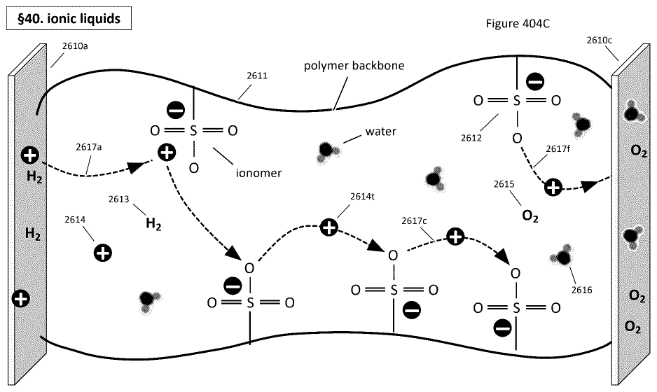

The effect of an ionic liquid on conduction must be considered in the context of the conduction mechanisms and polymer type the IL is doping. The cross sectional schematic shown in FIG. 404A depicts a proton exchange membrane comprising a polymer backbone 2611 with pendant attached ionomers 2612 spanning the gap between anode catalyst layer (ACL) 2610a and cathode catalyst layer (CCL) 2610c. Prior to operation, the matrix includes protons 2614 bound to ionomer 2612 along with the sparsely populated presence of H₂ crossover of hydrogen gas 2613 from the anode and seepage of oxygen O₂ 2615 from the cathode. In FIG. 404B, the ionization of ionomer 2612 releases protons 2614 free to conduct throughout the matrix along with water molecules 2614 naturally present in the hydrophilic polymer.

Some of the freed protons 2614 are able to hop from one ionomer to another via Grotthuss charge transport 2614t as depicted in FIG. 404C. As depicted they include hopping conduction 2617a from anode catalyst layer (ACL) 2610a to one of the membrane bound ionomers 2612, conduction 2617c by hopping from one ionomer 2612 to another, and by hopping from the ionomer 1612 to the cathode catalyst layer (CCL) 1517f. Although protons 2614 and water molecules may also combine to form hydronium ions, the contribution of hydronium ions and vehicular transport is neglected especially since the large size and immobility of IL cations excludes their involvement in hopping conduction.

Note that although the conduction path between ionomer to ionomer jump 2617c does not complete an electrical circuit with the conduction path 2617f from ionomer 2612 to CCL 2610c, charge neutrality is maintained within the membrane as the charges entering via conduction 2617a from the anode precisely counterbalance those exiting via conduction 2617f into the cathode. Since protons like electrons are indistinguishable from one another, the only charge accounting require is the net change in charge in accordance with charge conservation, aka Kirkoff's current law.

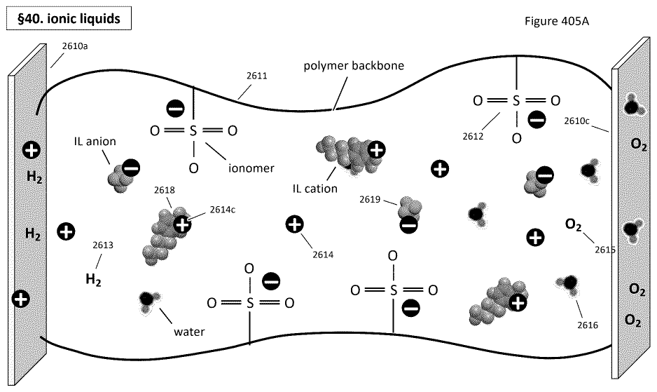

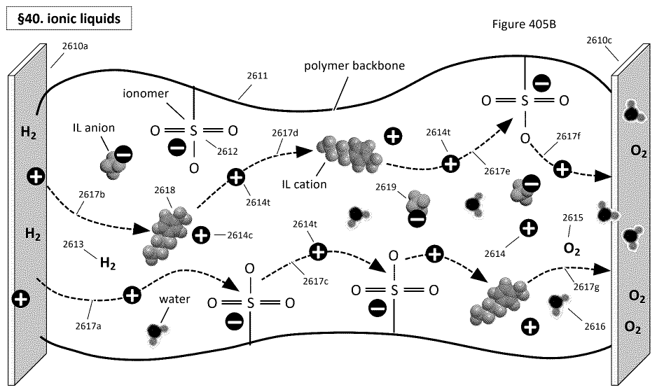

FIG. 405A illustrates the same membrane but doped with an ionic liquid, depicted as IL cation 2618 with embedded protonic charge 1614 and IL anion 2619 with an unnumbered embedded negative charge. Much like ionomers 2612 easily ionize to release free protons 2614, IL cations 2618 contain one net proton 2614c each which easily ionize to contribute additional charge transport carriers 2614t to the matrix. Electrically, protons 2614c and 2614 are indistinguishable as either or both enhance conductivity by increasing the preponderance of transport protons 2614t.

As shown in FIG. 405B, the addition of IL cation 2618 into the ionomeric matrix contributes additional protons 2614c separate and distinct from the protons 2614 released from the membrane bound ionomers 2612. The protons 2614c released from IL cation 2618 although indistinguishable from the ionomeric protons 2614 increase the total available charge carriers 2614t in the matrix and thereby enhance the film's conductance. As shown, protons emitted from the anode catalyst layer 2610a may conduct 2617a to a membrane bound ionomer 2612 or may conduct 2617b to IL cation 2618.

Within the membrane, protons may transfer from ionomer-to-ionomer 2617c, from IL-cation-to-cation 2617d, and betwixt IL-cations-and-ionomers 2617e. Protons also exit the membrane into the cathode catalyst layer 2610c from ionomer 2612 via conduction path 2617f or from IL cation 2618 via conduction path 2517g. Note IL anions 2619 do not conduct current in a PEM membrane as they are surrounded by ionized ionomers having affixed net negative charge holding the anions in place.

In this manner, ionic liquid doping enhances protonic conduction in a PEM membrane without affecting the membrane's structure or durability. The anionic component of the ionic liquid does not significantly enhance negative charge conduction of ionic anions, e.g. OH- and electrons, in the polymer matrix. This means the addition of ionic liquid doping does not adversely impact charge selectivity in a proton exchange membrane, i.e. the conductivity of protons is selectively enhanced while negative charge transport remains negligible. Curiously, because of IL's bipolar nature the addition of the same ionic liquid into an anionic membrane enhances negative ion conduction but does not enhance proton conduction. In other words, the mechanism of conduction of an ionic liquid depends on its surroundings, not only on its own chemical composition.

### Ionic Liquid Cations.

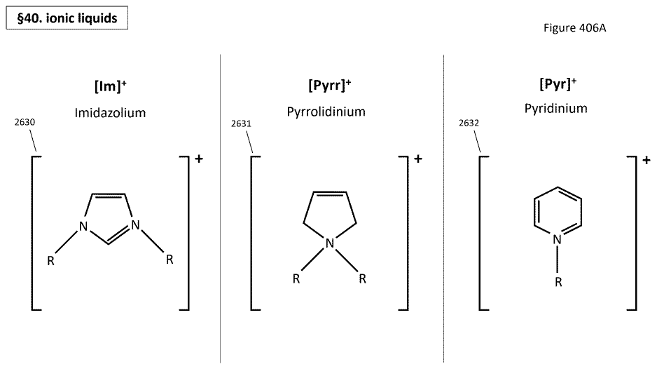

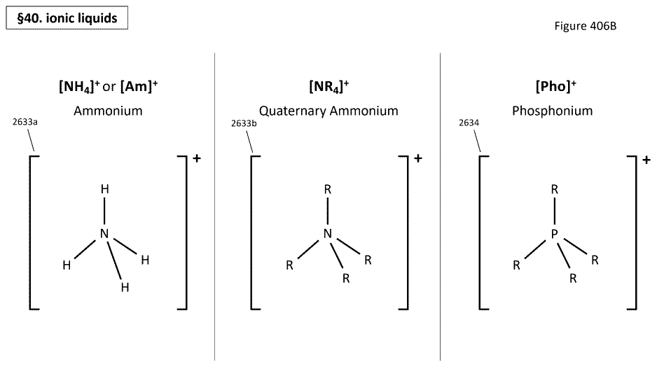

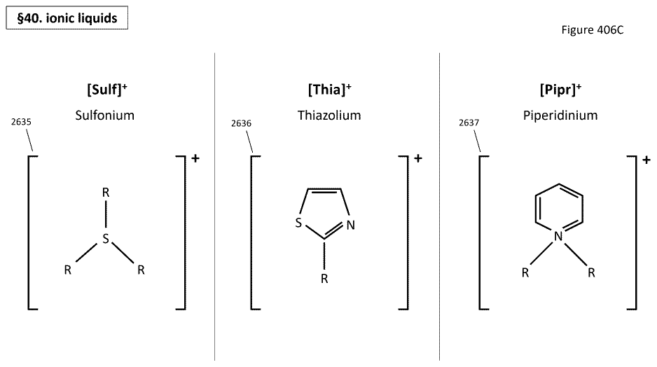

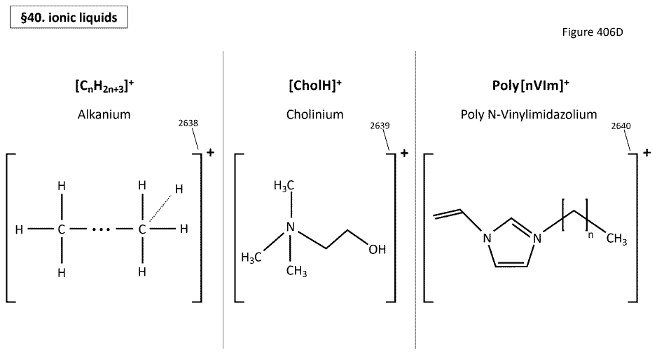

For IL doping of proton exchange layers, the magnitude of conductivity modulation depends on the concentration of IL doping and on the chemical species of the IL cation compound but not on the anion composition. A sample of possible IL cations able to be complexed in ionic salt precursors of various ILs include a variety of species:
imidazolium—shown in FIG. 406A, imidazolium 2630 comprises a protonated form of an organic aromatic heterocycle imidazole and ionic liquid cation with a chemical composition [C₃N₂H₃]⁺ abbreviated as [Im]⁺;
pyrrolidinium—also shown in FIG. 406A, pyrrolidinium 2631 comprises a protonated form of organic amine heterocycle pyrrolidine and ionic liquid cation having a chemical formulation [(CH₂)₄NH₂]⁺ and the abbreviation [Pyrr]⁺;
pyridinium—also shown in FIG. 406A, pyridinium 2632 comprises an aromatic conjugate acid of pyridine and ionic liquid cation having the chemical formulation [C₅H₅NH]⁺ abbreviated as [Pyr]⁺;
ammonium—as shown in FIG. 406B, the subclass ammonium comprises a positively charged polyatomic ion of ammonia and ionic liquid cation having the chemical formulas [NH₃]⁺ 2633a or as a quaternary ammonium cation with the form [NR₄]⁺ 2633b where R represents one or more hydrogen atoms replaced by organic groups or other compounds;
phosphonium—also shown in FIG. 406B, phosphonium 2634 comprises a positively-charged tetrahedral polyatomic ion and ionic liquid cation having the chemical formula [NR₄]⁺ where R represents a hydrogen atone or an alkyl, aryl, or halide group;
sulfonium—as shown in FIG. 406C, sulfonium 2635 comprises a positively charged organosulfur compound and ionic liquid cation with a chemical formula [SR₃]⁺ comprising three organic substituents R attached to a central sulfur core;
thiazolium—also shown in FIG. 406C, thiazolium 2636 comprises a protonated form of thiazole, a 5-membered heterocyclic sulfur-nitrogen compound and ionic liquid cation having the chemical formula [C₃H₄NS]⁺ and abbreviation [Tz]⁺;
piperidinium—also shown in FIG. 406C, piperidinium 2637 comprises a protonated form of the heterocyclic methylated amine piperidine and ionic liquid cation having the chemical formulation [C₅H₁₂N]⁺ abbreviated as [PipH]⁺;
protonated hydrocarbons (carbonium cations)—as shown in FIG. 406D, a broad class of positively charged protonated hydrocarbon solvents and ionic liquid cations referred to collectively as alkali carbonium aka alkanium 2638 including methanium, protonated methanol, ethanium, protonated ethanol, propanium, protonated propanol, butanium, protonated butanol, octonium, protonated acetone, protonated acetonitrile, protonated dimethyl sulfoxide [(DMSO)H]⁺, protonated toluene, protonated aniline, and others;
biochemical cations—biochemical cations comprise a diverse class of positively-charged and protonated organic compounds formed by or participating in biochemical reactions including carbonium (described above) and protonated choline 2639 shown in FIG. 406D, along with protonated creatine, protonated arginine, protonated lysine, protonated histidine, etc.;
superbase cations—superbase cations result from superbase reactions where a strong base such as ammonium, phosphonium, sulfonium, phosphazene, amidine, guanidine, and other onium ions becomes protonated forming IL pairs or releasing the sequestered protons thereby influencing ionic conductivity.; and,
poly ionic liquids—copolymers of ionic salts exemplified by vinyl functionalized imidazolium shown in FIG. 406D and by vinyl pyrrolidinium (not shown) including numerous variants mirroring those of their fundamental cation radical offer added control over ionomeric conductivity, thermal stability, and changing hydration.

Many but not all cations of ionic liquids comprise onium ions representing a broad class of cations derived from neutral molecules through the addition of a proton (H⁺) or other cations. Onium ions contain a central atom, often of nitrogen, phosphorus, sulfur, or oxygen, carrying a positive charge. Of the foregoing, some cationic superbases are onium ions, but not all superbases are onium ions.

Simple onium cations comprise hydrides with no substitutions. They include Group-13 cations such as boronium, i.e. pronated boron [BH₄]⁺ and pronated boranes [BₓH_{y}]⁺ a Group-14 cations comprising carbonium ions aka hydrocarbons [CₙH₂ₙ₊₃]⁺, silanium [SiH₅]⁺, germonium [GeH₅]⁺, stannonium [SnH₃]⁺, plumbonium [PbH₃]⁺, and flerovonium [FIH₃]⁺. They also include Group-15 onium cations referred to as pnictogen ions comprising ammonium [NH₄]⁺, phosphonium [PH₄]⁺, arsonium [AsH₄]⁺, stibonium [SbH₄]⁺, bismuthonium [BiH₄]⁺, and moscovonium [McH₄]⁺.

Non-radiative Group-16 onium cations, i.e. chalcogens include sulfonium [H₃S]⁺, selenonium [H₃Se]⁺, and telluronium [H₃Te]⁺. Group-17 halogen-based onium cations, also known as halonium ions [H₂×]⁺ include fluoronium [H₂F]⁺, chloronium [H₂Cl]⁺, bromonium [H₂Br]⁺, and iodonium [H₂I]⁺. Pseudo-halogen onium cations include protonated hydrogen azide aka aminodiazonium, and protonated hydrogen cyanide and its isomers referred to as hydrocyanonium or methylidyneammonium. Other simple onium cations comprise Group-18 noble gasses of helium, neon, argon, krypton, and xenon.

Onium cations with monovalent substitutions include ‘primary ammonium’ cations [RH₃N]⁺ of hydroxylammonium, methylammonium, ethylammonium, hydrazinium, and anilinium; secondary ammonium cations [R₂HN₂]⁺ comprising dimethylammonium, diethylammonium, ethylmethylammonium, and diethanolammonium; tertiary ammonium cations [R₃NH]⁺, and quaternary ammonium cations [NR₄]⁺ including tetrafluoroammonium, tetramethylammonium, tetraethylammonium, tetrapropylammonium, tetrabutylammonium, trimethyl ammonium compounds, didecyldimethylammonium, and pentamethylhydrazinium. Similarly monovalent substitutions include quaternary phosphonium cations [PR₄]⁺ such as tetraphenylphosphonium; quaternary arsonium cations [AsR₄]⁺ such as tetraphenylarsonium; and quaternary stibonium cations [SbR₄]⁺ such as tetraphenylstibonium.

Other onium cations with monovalent substitutions include ‘primary cations' of sulfonium [RSH₂]⁺ comprising protonated thiols; primary cations of fluoronium [RFH] comprising protonated fluorides; and primary cations of oxonium [ROH₂]⁺ comprising protonated alcohols [(ROH)H]⁺ and protonated hydrogen peroxide [(H₂O₂)H]⁺ including methyloxonium, ethyloxonium, and dioxidanonium. ‘Secondary cations' include secondary sulfonium cations [R₂SH]⁺; secondary fluoronium cations [R₂F]⁺ such as dichlorofluoronium; secondary iodonium cations [R₂I]⁺ such as diphenyliodonium; and secondary oxonium cations [R₂OH]⁺ comprising protonated ethers such as dimethyloxonium. ‘Tertiary cations’ include tertiary sulfonium cations [R₃S]⁺ comprising trimethylsulfonium; tertiary selenonium cations [R₃Se]⁺ comprising triphenylselenonium; tertiary telluronium cations [R₃Te]⁺ comprising triphenyltelluronium; and oxonium cations [R₃O]⁺ including trifluorooxonium, trimethyloxonium, triethyloxonium, oxatriquinacene, and oxatriquinane.

Onium cations with polyvalent substitutions include secondary ammonium cations comprising diazenium, guanidinium; tertiary ammonium cations comprising nitrilium and diazonium; cyclic tertiary ammonium cations containing nitrogen [RNHR]⁺ such as pyridinium; and various quaternary ammonium cations. Quaternary ammonium cations with a one double-bond of the form [R═NR₂]⁺ include iminium, diazenium, and thiazolium. Quaternary ammonium cations with two double-bond substitutions having the form [R═N=R]⁺ include bis(triphenylphosphine)iminium and nitronium. Quaternary ammonium cations having a triple bond in the form [R—NR]⁺ include diazonium and nitrilium. Other onium cations with polyvalent substitutions include tertiary oxonium cations with a triple-bonded substitution having a form [R≡O]⁺ comprising acylium ions and nitrosonium; and cyclic tertiary oxonium cations of the form [ROR]⁺ comprising pyrylium. Tertiary sulfonium cations with triple bonds of the form [N-S]⁺ include thionitrosyl.

Pronated nitric acid and sulfuric acid cations with polyvalent substitutions include dihydroxyoxoammonium [H₂NO₃]⁺ and trihydroxyoxosulfonium [H₃SO₄]⁺ respectively. Doubly pronated cations include hydrazinediium, diazenediium, and diazynediium. Hydride-based enium cations include protonated borylenes; carbenes, alkenes including methylene and ethene; benzene; tropylidene; silylenes; nitrenes; phosphinidene; and organomercury compounds.

### Ionic Liquid Anions.

The IL anion comprises the complementary component to the cation of an ionic liquid. Because the attraction between cation and anion is ionic, there is no requirement for covalent bonding between the ionic radicals. As such, a potentially unlimited number of combinations of ionic liquids are possible. The design of organic liquids for use in a proton exchange membrane commonly involves an organic cation combined with either inorganic or organic anions.

Rather than controlling conductivity of a PEM membrane the way the IL cation does, the main influence of the IL anion radical on proton ionomers is its impact of the dissociation temperature of the ionic salt forming the ionic liquid. Although today the temperature where the cation and anion of an ionic salt is now commonly referred to as its dissociation temperature T_{d} older publications refer to this condition as the melting temperature Tₘ of the ionic salt.

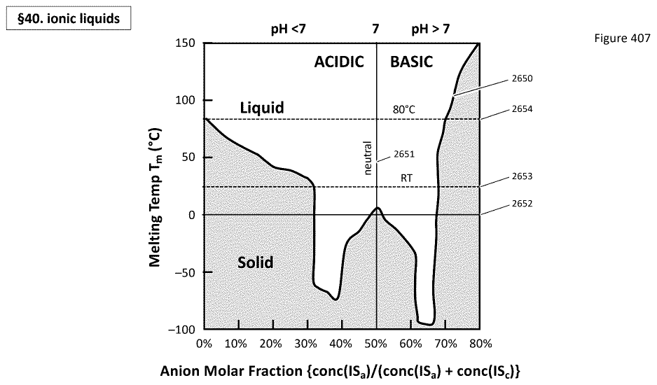

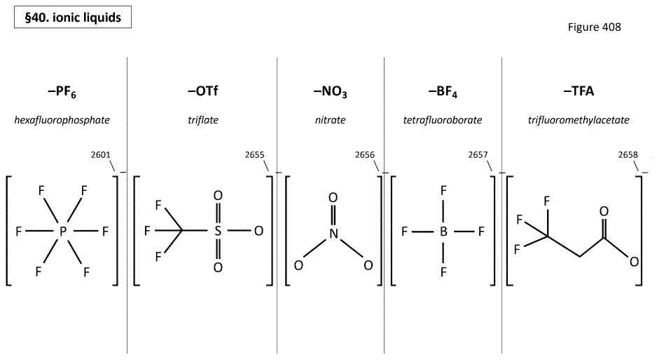

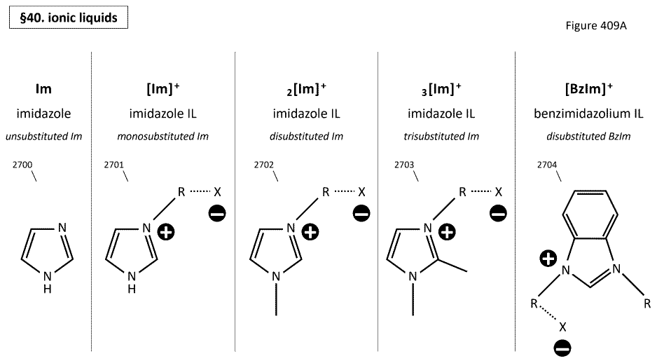

FIG. 407 illustrates an example of the effect of the anion concentration on the melting temperature of an ionic salt in graphical form. The anion concentration is represent on the abscissa as the molar fraction of the anion comprising the ionic salt. The molar fraction measured in percentage is defined as the molar concentration of the ionic salt anion, or conc(ISₐ) compared to the total molar concentration of the anion and cation salt components {conc(ISₐ)+conc(IS_{c})}.

Line 2651 represents the 50% condition where the two ionic concentration are equal, i.e. conc(ISₐ)=conc(IS_{c}). In such a case, above its melting temperature the ionic liquid is neutral, being neither acidic or basic. As labelled on the second x-axis, this neutral condition is described as pH=7. The parameter pH is defined by the negative logarithm of the hydrogen ion concentration conc(H). For higher anion molar concentrations where conc(ISₐ) >conc(IS_{c}), the proton absorbing ability of the solution dominates its available protons and the IL becomes basic with a corresponding pH>7. For lower anion molar concentrations, i.e. where conc(ISₐ)<conc(IS_{c}) the proton donating cations dominate ionic chemistry and the IL becomes acidic with pH<7.

The ordinate axis represent the melting temperature of the ionic salt in degrees Centigrade. For reference, line 2652 represents the temperature T=0° C., the melting point of water at one atmosphere pressure. While this reference is meaningful experientially, its relevance in a proton exchange membrane is uncertain as ionomers and dopants in the membrane may alter water's freezing point. For an exemplary ionic salt curve 2650 represents the solid-liquid phase transition of the ionic dopant—below the line the ionic dopant comprises a solid ionic salt, above the line the ionic salt melts into an ionic liquid. The following table illustrates the influence of anion species on IL melting point by comparing compounds based on the same cation 1-ethyl-3-methylimidazolium:

| | IL Anion | Anion | Melting |
|---|---|---|---|
| IL Cation | Name | Equation | Temp Tₘ |
| [EtMeIm]⁺ | carborane | [CB₁₁H₁₂]⁻ | 122° C. |
| [EtMeIm]⁺ | chlorinated carborane | [CB₁₁H₆Cl₆]⁻ | 114° C. |
| [EtMeIm]⁺ | chloride | [CI]⁻ | 87° C. |
| [EtMeIm]⁺ | boride | [Br]⁻ | 81° C. |
| [EtMeIm]⁺ | iodide | [I]⁻ | 80° C. |
| [EtMeIm]⁺ | sulfate | [SO₄]⁻•H₂O₂ | 70° C. |
| [EtMeIm]⁺ | ethylated carborane | [C₂H₅CB₁₁H₁₁]⁻ | 64° C. |
| [EtMeIm]⁺ | hexafluorophosphate | [PF₆]⁻ | 62° C. |
| [EtMeIm]⁺ | methylated carborane | [CH₃CB₁₁H₁₁]⁻ | 59° C. |
| [EtMeIm]⁺ | gold trichloride | [AuCl₃]⁻ | 58° C. |
| [EtMeIm]⁺ | nitrogen dioxide | [NO₂]⁻ | 55° C. |
| [EtMeIm]⁺ | arsenic hexafluoride | [AsF₆]⁻ | 53° C. |
| [EtMeIm]⁺ | gallium (III) chloride | [GaCl4]⁻ | 47° C. |
| [EtMeIm]⁺ | nitrate | [NO₃]⁻ | 38° C. |
| [EtMeIm]⁺ | tetrafluoroborate | [BF₄]⁻ | 15° C. |
| [EtMeIm]⁺ | tetrachloroaluminate | [AlCl₄]⁻ | 7° C. |
| [EtMeIm]⁺ | bis(trifluoromethyl- | [Tf₂N]⁻ | −3° C. |
| | sulfonyl)imide | | |
| [EtMeIm]⁺ | triflate | [TfO]⁻ | −9° C. |
| [EtMeIm]⁺ | trifluoromethane- | [TFSA]⁻ | −14° C. |
| | sulfonic anhydride | | |
| [EtMeIm]⁺ | dicyanamide | [N(CN)₂]⁻ | −21° C. |
| [EtMeIm]⁺ | acetate anion | [C₂H₃O₂]⁻ | −45° C. |

Notice the melting point of the ionic salt varies nonlinearly and non-monotonically with the anion mole fraction exhibiting two meting point minima at 38% and 66% and high melting points at concentration extremes. At neutral pH, the ionic liquid behaves like undoped water with a zero degree melting point. Line 2653 represents room temperature, i.e. where T=25° C. As shown, the ionic salt is in its liquid form at room temperature for any anion molar fractions between 31% and 77%. At 80° C., the temperature at which PFSA ionomers and many other proton exchange membranes operate, the usable range of the ionomer expands greatly.

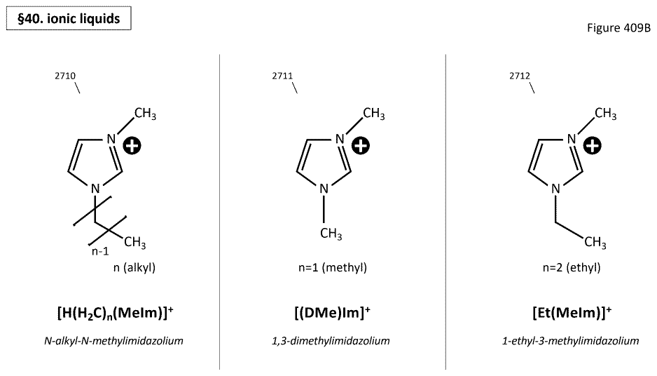

A small sampling of exemplary anions [ILₐ]⁻ used in ionic liquids are shown in FIG. 408.

These negatively charge ionic species include the following inorganic compounds:
bis(fluorosulfonyl)imide [FSO₂NSO₂F]⁻
borate [BO₃]₃⁻
borohydride [BH₄]⁻
bromide [Br]⁻
bromate [BrO₃]⁻
chlorate [ClO₃]⁻
chloride [Cl]⁻
chlorochromate [CrO₃Cl]⁻
chromate [CrO₄]₂⁻
copper chloride [CuCl₂]⁻
dihydrogen phosphate [H₂PO₄]⁻
dichromate [Cr₂O₇]²⁻
fluoride [F]⁻
fluorohydrogenate anion [(FH)ₙF]⁻
hexafluorophosphate [PF₆]⁻ anion 2601
hydrogen phosphate [HPO₄]²⁻
hydrogen sulfate [HSO₄]⁻
hydrogen sulfite (bisulfite) [HSO₃]⁻
hydroxide [OH]⁻
hypochlorite [ClO]⁻
iodate [IO₃]⁻
iodide [I]⁻
metasilicate [SiO₃]²⁻
molybdate [MoO₄]²⁻
nitrate [NO₃]⁻ anion 2656
perchlorate [ClO₄]⁻
periodate [IO₄]⁻
permanganate [MnO₄]⁻
phosphate [PO₄]³⁻
silicate [SiO₄]⁴⁻
sulfate [SO₄]²⁻
sulfite [SO₃]²⁻
superoxide [O₂′]⁻
tetraborate [B₄O₇]²⁻
tetrafluoroborate [BF₄]⁻ anion 2657
thiosulfate [S₂O₃]²⁻
tribromide [Br₃]⁻
tungstate [WO₄]²⁻
zinc chloride [Zn₆Cl₃]⁻

Exemplary organic anions employed in ionic liquids, i.e. organic [ILₐ]⁻, include:
acrylate [ACR]⁻
acetate [OAc]⁻ or [CH₃COO]⁻ or [C₂H₃O₂]⁻
benzenesulfonate [C₆H₅SO₃]⁻
benzoate [C₆H₅COO]⁻
bis(trifluoromethylsulfonyl)imide [NTf₂]⁻ or [Tf₂N]⁻
bis(2-ethylhexyl) sulfosuccinate [AOT]⁻
bis(2-ethylhexyl) phosphate [DEHP]⁻
bis(fluorosulfonyl)imide [FSO₂N⁻SO₂F]⁻ or [FSI]⁻
bis(trifluoromethylsulfonyl)imide or bistriflimide [Tf₂N]⁻, [NTf₂]⁻′ or [TfSi]⁻
butyrate [C₃H₇COO]⁻
carbonate [CO₃)²⁻
citrate [C₆H₅O₇]³⁻
cyanate [OCN]⁻
dicyanamide [DCA]⁻ or [N(CN)₂]⁻
diethylphosphate [(C₂H₅O)₂PO₂]⁻ or [DEP]⁻
dodecanesulfate [DS]⁻
ethoxide [C₂H₅O]⁻
ethylsulfate [EtSO₄]⁻
ethylsulfonate [C₂H₅SO₃]⁻
ferricyanide [Fe(CN)₆]³⁻
ferrocyanide [Fe(CN)₆]⁴⁻
formate [HCOO]⁻ or [OFm]⁻
hydrogen carbonate (bicarbonate) [HCO₃]⁻
L-lysinate [Lys]⁻
malonate dianion [Mal]²⁻
mesylate [CH₃SO₃]⁻
methoxide [CH₃O]⁻
methanesulfonate [CH₃SO₃]⁻
methylphosphate dianion [MeP]²⁻
dimethylphosphate [(CH₃O)₂PO₂]⁻ or [DMeP]⁻
methanesulfonate [MeSO₃]⁻
octanoate [C₇H₁₅COO]⁻ or [C₈H₁₅O₂]⁻
oxalate [C₂O₄]²⁻
phthalate [C₈H₄O₄]²⁻
propionate [C₂H₅COO)⁻ or [OPr]⁻
sulfonate [RSO₃]⁻
tartrate [C₄H₄O₆]²⁻
trifluoroacetate [CF₃COO]⁻ or [C₂F₃O₂]⁻
tetracyanoborate [B(CN)₄]⁻
thiocyanate [SCN]⁻
thiosulfate [S₂O₃]²⁻
tosylate [p-CH₃C₆H₄SO₃]⁻
tricyanomethanide [C(CN)₃]⁻
triflate [CF₃SO₃]⁻
trifluoromethanesulfonate (triflate) [-OTf], [TfO]⁻ or [CF₃SO₃]⁻ anion 2655, and
trifluoromethylacetate [F₃MeAc]⁻ or [-TFA] anion 2658

Broadly speaking, the impact of the anion on the melting point and physical properties of an ionic salt and ionic liquid depends on its size and molecular charge density. Specifically smaller and less polarizable anions (like [Cl]⁻, [B]r⁻, and [NO]₃⁻) tend to pair well with cations that have a lower charge density and larger size, such as ammonium and imidazolium cations. These combinations typically result in lower melting points and higher ionic conductivity. ILs with monovalent anions are generally more stable and soluble in a variety of solvents. This makes them easier to synthesize and more suitable for use in batteries, fuel cells, and as green solvents.

Larger and more polarizable anions (like [SO₄]²⁻, [PO₄]³⁻, and organic anions) are better paired with cations that have a higher charge density and smaller size, such as carbonium cations. Multivalent anion often result in ILs with higher melting points and unique solvation properties, exhibiting lower solubility in common solvents and higher thermal stability. These properties can be advantageous in specific applications such as high-temperature processes and specialized separations possibly adaptable for use in high temperature fuel cells.

While examples of various ionic liquids applicable for use in ion exchange membranes and electrochemical devices such as fuel cells, hydrolyzers, batteries, and supercapacitors are nearly unlimited, it is convenient to consider ILs arranged in groups according to the category of cation used in its synthesis. In such analysis to categorize the ILs by the cation family on which the IL is based.

### Imidazolium ILs.

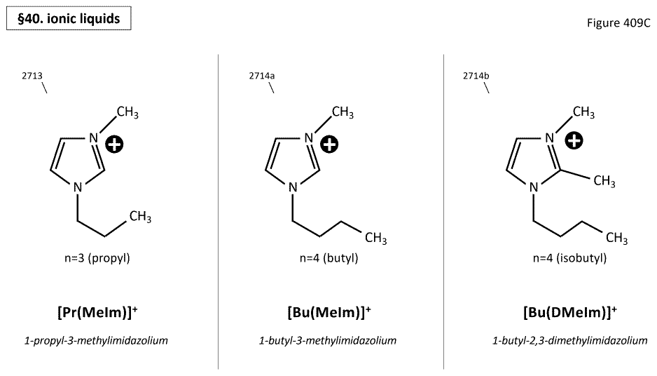

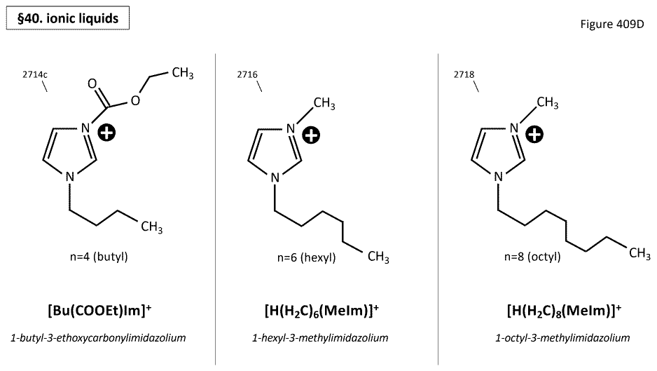

One such category shown in FIG. 409A is the pentagonal cyclic organic molecule imidazole 2700 abbreviated Im. In its pristine unsubstituted form, neutral imidazole has the chemical formula C₃N₂H₄ with three carbon-hydrogen pairs and two on-ring nitrogen atoms, only one of which is bonded to an extra hydrogen. Converting neutral imidazole into the cation imidazolium [Im]⁺ to form ionic liquid 2701 involves attaching a single radical R to the un-hydrogenated nitrogen, a process referred to as a monosubstitution. The resulting ionic liquid comprises the singly-charged [Im]⁺ cation counterbalanced by an unspecified anion species X.

In its disubstituted form ₂[Im]⁺ 2702, a second substitution reaction strips hydrogen from the other nitrogen attaching a neutrally charged radical to the ring. Similarly in trisubstituted imidazolium₃[Im]⁺ 2703, a second neutral radical is attached to one of the carbon atoms. Yet another variant involves merging the imidazolium ring with a benzene ring (Bz) to form the disubstituted monovalent cation benzimidazolium [BzIm]⁺ 2704.

Because an attached radical can also comprise one of a large family of organic molecules containing varying counts of constituent linearly arranged carbon atoms called ‘alkyls’, imidazolium [Im]⁺ cations represent an impressive array of IL cation options. The principle of facile designer-cations for ionic liquids is depicted schematically as N-alkyl-N-methylimidazolium [CₙMeIm]⁺ radical 2710 in FIG. 409B. As shown, the disubstituted imidazolium ring attached to two methane (CH₃) groups, one directly, the second through an alkane chain of ‘n’ carbon atoms. The number of carbon atoms ‘n’ in the sidechain group including its terminus carbon determine the name of the compound as described in the table below.

| n | alkyl prefix | linear formula | Im cation | abbreviation |
|---|---|---|---|---|
| 1 | N-methyl | —CH₃ | 1,3-methylimidazolium | [DMeIm]⁺ |
| 2 | N-ethyl | —(CH₂)CH₃ | 1-ethyl-3-methylimidazolium | [EtMeIm]⁺ |
| 3 | N-propyl | —(CH₂)₂CH₃ | 1-propyl-3-methylimidazolium | [PrMeIm]⁺ |
| 3 | iso-propyl | —CH(CH₃)₂ | 1-isopropyl-3-methylimidazolium | [i-PrMeIm]⁺ |
| 4 | N-butyl | —(CH₂)₃CH₃ | 1-butyl-3-methylimidazolium | [BuMeIm]⁺ |
| 4 | iso-butyl | —(CH₂)CH(CH₃)₂ | 1-isobutyl-3-methylimidazolium | [i-BuMeIm]⁺ |
| 4 | sec-butyl | —CH(CH₃)(CH₂)CH₃ | 1-secbutyl-3-methylimidazolium | [s-BuMeIm]⁺ |
| 4 | tert-butyl | —C(CH₃)₃ | 1-tertbutyl-3-methylimidazolium | [t-BuMeIm]⁺ |
| 5 | N-pentyl | —(CH₂)₄CH₃ | 1-pentyl-3-methylimidazolium | [C₅MeIm]⁺ |
| 5 | tert-pentyl | —C(CH₃)₂(CH₂)CH₃ | 1-tertpentyl-3-methylimidazolium | [t-C₅MeIm]⁺ |
| 6 | N-hexyl | —(CH₂)₅CH₃ | 1-hexyl-3-methylimidazolium | [C₆MeIm]⁺ |
| 7 | N-heptyl | —(CH₂)₆CH₃ | 1-heptyl-3-methylimidazolium | [C₇MeIm]⁺ |
| 8 | N-octyl | —(CH₂)₇CH₃ | 1-octyl-3-methylimidazolium | [C₈MeIm]⁺ |
| 10 | N-decyl | —(CH₂)₉CH₃ | 1-decyl-3-methylimidazolium | [C₁₀MeIm]⁺ |

The number of carbon atoms in the linear chain determines the name of the prefix to the imidazolium root word. For example, an imidazolium cyclic ring with two attached methyl groups and no intervening carbon atoms shown in FIG. 409B is referred to as the alkyl compound 1,3-methylimidazolium [DMeIm]⁺ where n=1. When n=2, the side group is referred to as ‘ethyl’ with the symbol Et. Accordingly, imidazolium 2712 variant is referred to as 1-ethyl-3-methylimidazolium with the abbreviation [EtMeIm]⁺.

FIG. 409C includes examples of imidazolium cations containing longer carbon chains. For example, when n=3 in imidazolium variant, the carbon chain is referred to as a ‘propyl’ group and the cation is thusly named 1-propyl-3-methylimidazolium 2713 with corresponding abbreviation [PrMeIm]⁺. Alternatively, in a related isomer 1-isopropyl-3-methylimidazolium [iPrMeIm]⁺ (not shown) the cation comprises a C-H trunk forming a Y-shaped tree with two CH₃ branches. Despite its Y-shaped structure, the total number of carbon atoms in the aggregate isopropyl side group is identical to that of its linear propyl counterpart, i.e. n=3.

Imidazolium may also comprise n=4 four-carbon alkyl side groups called ‘butyl’ groups forming linear or Y-branched structures attached to the imidazolium cyclic ring. As a disubstituted imidazolium cation, the molecule 1-butyl-3-methylimidazolium [BuMeIm] 2714a comprises methyl (CH₃) and linear butyl side groups.

In the trisubstituted IL cation 1-butyl-2,3-dimethylimidazolium 2714b, the imidazolium aromatic ring comprises three appendages, namely two methyl groups (CH₃) with no intervening carbon between the carbon termini and its cyclic ring; and a third side comprising the butyl group including a methyl terminus. Accordingly 1-butyl-2,3-dimethylimidazolium 2714b is abbreviated as [BuDMeIm]⁺ where ‘Bu’ denotes the linear butyl group and the ‘DMe’ term refers to the two methyl groups one of which bonds to nitrogen the other to carbon. Another disubstituted [Im]⁺ cation 1-butyl-3-ethoxycarbonylimidazolium shown in FIG. 409D comprises the combination of a n=4 butyl group attached in the first position and a ethoxycarbonyl group. Other butyl imidazolium variants (not shown) include isobutyl, sec-butyl, and tert-butyl functional groups. In the case of isobutyl, a concatenation of isomer and butyl, a second methyl group is located on the second carbon of the carbon chain forming a branched structure.

In this sense, the prefix ‘iso’ is employed when all carbon side groups attached to the cyclic form a continuous chain except for one. Also applicable in four carbon butyl chains, the terms sec-butyl or s-butyl refer to a isomer where a functional group is bonded on the second atom, and the term tert-butyl or t-butyl where a functional group is bonded onto the tertiary atom.

In 1-hexyl-3-methylimidazolium [CsMeIm]⁺ 2716 the hexyl group comprises an organic chain where n=6. Although the abbreviation for hexyl can be the letter H, there is an ambiguity with the prefix hepta meaning n=7 carbons. As such, in this work the numeric based prefix C₆ is preferred. Likewise where n=8, the cation referred to as 1-octyl-3-methylimidazolium 2718 has the abbreviation [CsMeIm]⁺. The following table lists a variety of imidazolium based IL cations and exemplary anions:

| | IL Cation | | |
|---|---|---|---|
| | Chemical | Cation | Exemplary |
| Category | Compound | Symbol | Anions |
| Imidazolium | imidazolium | [Im]⁺ | [AOT]⁻, |
| | | | [ACR]⁻, |
| | N-alkyl-N- | [CₙMeIm]⁺ | [Oac]⁻, |
| | methylimidazolium | | [BF₄]⁻, |
| | | | [FSI]⁻, |
| | 1,3-dimethyl- | [DMeIm]⁺ | [Cl]⁻, |
| | imidazolium | | [DEP]⁻, |
| | | | [DS]⁻, |
| | 1-ethyl-3- | [EtMeIm]⁺ | [I]⁻, |
| | methylimidazolium | | [MeSO₃]⁻, |
| | 1-propyl-3- | [PrMeIm]⁺ | [NO₃]⁻, |
| | methylimidazolium | | [O₂^{•}]⁻, |
| | | | [Opr]⁻, |
| | 1-butyl-3- | [BuMeIm]⁺ | [PF₆]⁻, |
| | methylimidazolium | | [RSO₃]⁻, |
| | 1-butyl-2,3- | [BuDMeIm]⁺ | [SCN]⁻, |
| | dimethylimidazolium | | [TfO]⁻, |
| | 1-butyl-3-ethoxy- | [Bu(COOEt)Im]⁺ | [TfSI]⁻, |
| | carbonylimidazolium | | [C(CN)₃]⁻, |
| | 1-pentyl-3- | [C₅MeIm]⁺ | [Tf₂N]⁻ |
| | methylimidazolium | | |
| | 1-hexyl-3- | [C₆MeIm]⁺ | |
| | methylimidazolium | | |
| | 1-methyl-3- | [MeOctIm]⁺ | |
| | octylimidazolium | | |
| | 1-octyl-3- | [C₈MeIm]⁺ | |
| | methylimidazolium | | |
| | 1-decyl-3- | [C₁₀MeIm]⁺ | |
| | methylimidazolium | | |
| | 3-methyl-(ethoxy- | [Me(COOEtMe)Im]⁺ | |
| | carbonylmethyl)- | | |
| | imidazolium | | |

In a related isomer 1-methyl-3-octylimidazolium [MeOctIm]⁺ the constituent functional groups are identical but the positions of the methyl and octyl groups attached to the imidazolium ring are swapped. Specifically in 1-methyl-3-octylimidazolium, the methyl group is attached to the nitrogen atom at position 1 of the imidazolium ring while the octyl group is attached to the nitrogen atom at position 3. Conversely for 1-octyl-3-methylimidazolium, the n=8 alkyl group is attached to position 1 and the methyl group is bound to position 3.

The list is by no means complete or even exhaustive, but intended simply to represent some exemplary molecular forms. Similarly the anions listed may be considered independently from the cations used to form the ionic liquid. Together the various permutations and combinations of I_{L} cations and IL anions listed produce an extensive array of ionic liquids available for doping proton exchange membranes. The selection of cation and anion for an ionic liquid depends involves numerous factors including conductivity, durability, stability, operating temperature range, humidity, toxicity and RoHS, and compatibility with the ionomeric polymer used to form the film.

In particular, although imidazolium cations can be paired with either monovalent or multivalent anions, due to preferable physical properties such as low melting point and stability they are generally formed using ionic salts with monovalent anions. As such, only monovalent anions are listed in the above table.

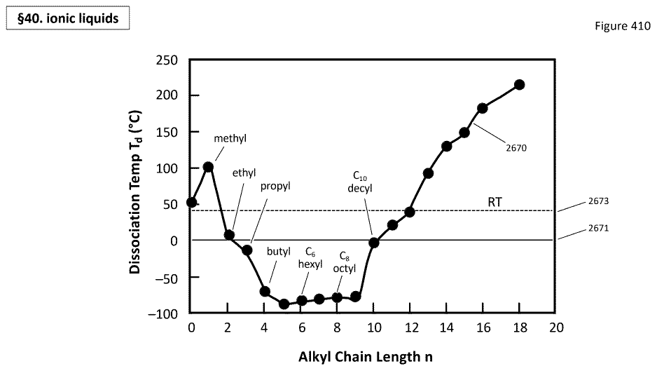

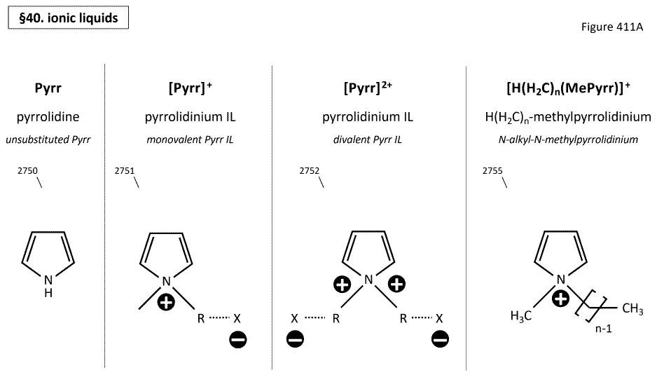

As described previously, the anion radical has a direct effect on the phase transition temperature from ionic salt to ionic liquid and less impact on proton conductivity. That said, the cation can also influence the dissociation temperature of an ionic liquid. For example, in FIG. 410 the number of carbon atoms ‘n’ linearly assembled in an alkane chain attached to the cyclic ring of imidazolium has a direct effect its dissociation temperature. As shown, the phase transition 2670 between ionic solid and ionic liquid states exhibits a U-shaped dependance on the carbon chain length with a minima at −90° C. over the range 4≤n≤9, well below the freezing point of water 2671 and room temperature 2673.

### Pyrrolidinium ILs.

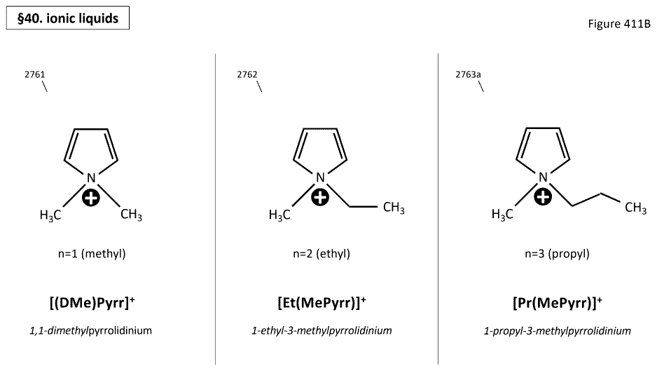

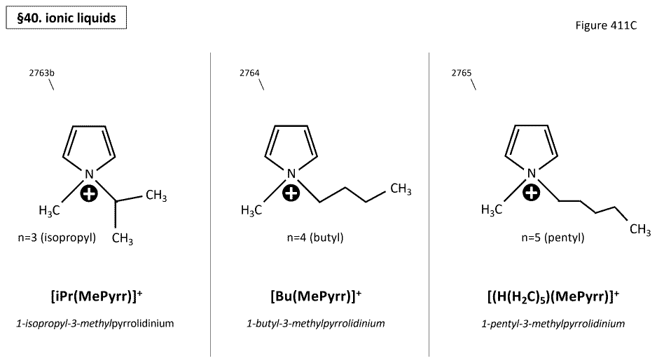

As shown in FIG. 411A, pyrrolidinium is the cation of an ionic salt based on pyrrolidine 2750, a pentagonal aromatic cyclic compound with a single on-ring amine (NH) substitution and with a formula (CH₂)₄NH. By gaining a single proton in a substitution of the amine (NH) group, the monovalent pyrrolidinium cation [Pyrr]⁺ is expressed chemically as [C₄H₁₀N]⁺.

As depicted in the same illustration, a monovalent pyrrolidinium cation [Pyrr]⁺ 2751 forms a solid ionic salt (IS) or and ionic liquid IL with anion X or more accurately [X]⁻ which may comprise any number of possible combinations, the only difference being whether the ambient temperature is higher or lower than the dissociation temperature (T_{d}) of the ionic salt, also often referred to as the salt's melting temperature (Tₘ). It should be noted that although the synthesis of pyrrolidinium involves a monosubstitution of the on-ring NH, the attachment actually comprises two side-groups, not one, where both groups are attached to the same nitrogen atom.

In a monovalent substitution, only one of the side groups is electrically charged. The second group is neutral. By contrast in the divalent pyrrolidinium cation 2752, both side groups are electrically charged. The divalent pyrrolidinium cation [Pyrr]²⁺ is expressed chemically as [C₄H₁₁N]²⁺ recognizing the cyclic ring attaches to two hydrogen ions not present in neutral pyrrolidine. To maintain charge neutrality, the divalent pyrrolidinium cation [Pyrr]²⁺ must be balanced by two single charged anions [X]⁻ or optionally a one doubly-ionized anion [X]²⁻.

Both the monovalent and divalent pyrrolidinium cations 2751 and 2752 are represented as bonded to a radical R. The most common substituted radicals R comprise a methyl or alkyl groups. Strictly speaking, a methyl group is a degenerate case of an alkyl group comprising only the terminus carbon and lacking any intervening carbon atoms, i.e. where n=1. The genericized form of a monovalent pyrrolidinium cation is N-alkyl-N-methylpyrrolidinium 2755 where the alkyl group may vary in length ‘n’ in accordance with the following table:

| n | alkyl prefix | linear formula | Pyrr cation | abbreviation |
|---|---|---|---|---|
| 1 | N-methyl | —CH₃ | 1,1-methylpyrrolidinium | [DMePyrr]⁺ |
| 2 | N-ethyl | —(CH₂)CH₃ | 1-ethyl-1-methylpyrrolidinium | [EtMePyrr]⁺ |
| 3 | N-propyl | —(CH₂)₂CH₃ | 1-propyl-1-methylpyrrolidinium | [PrMePyrr]⁺ |
| 3 | iso-propyl | —CH(CH₃)₂ | 1-isopropyl-1-methylpyrrolidinium | [iPrMePyrr]⁺ |
| 4 | N-butyl | —(CH₂)₃CH₃ | 1-butyl-1-methylpyrrolidinium | [BuMePyrr]⁺ |
| 4 | iso-butyl | —(CH₂)CH(CH₃)₂ | 1-isobutyl-1-methylpyrrolidinium | [i-BuMePyrr]⁺ |
| 4 | sec-butyl | —CH(CH₃)(CH₂)CH₃ | 1-secbutyl-1-methylpyrrolidinium | [s-BuMePyrr]⁺ |
| 4 | tert-butyl | —C(CH₃)₃ | 1-tertbutyl1-methylpyrrolidinium | [t-BuMePyrr]⁺ |
| 5 | N-pentyl | —(CH₂)₄CH₃ | 1-pentyl-1-methylpyrrolidinium | [C₅MePyrr]⁺ |
| 5 | tert-pentyl | —C(CH₃)₂(CH₂)CH₃ | 1-tertpentyl-1-methylpyrrolidinium | [t-C₅MePyrr]⁺ |
| 6 | N-hexyl | —(CH₂)₅CH₃ | 1-hexyl-1-methylpyrrolidinium | [C₆MePyrr]⁺ |
| 7 | N-heptyl | —(CH₂)₆CH₃ | 1-heptyl-1-methylpyrrolidinium | [C₇MePyrr]⁺ |
| 8 | N-octyl | —(CH₂)₇CH₃ | 1-octyl-1-methylpyrrolidinium | [C₈MePyrr]⁺ |
| 10 | N-decyl | —(CH₂)₉CH₃ | 1-decyl-1-methylpyrrolidinium | [C₁₀MePyrr]⁺ |

In accordance with alkyl sequential naming standard methyl-ethyl-propyl-isopropyl-butyl or ‘MEPIB’ or denoting the carbon number sequence, a myriad of combinations of pyrrolidinium molecules are possible. Recognizing the on-ring nitrogen atom in pyrrolidinium form bonds with not one but two side groups, the number of possible permutations and combinations is almost inconceivable. To simplify this matrix, it is convenient to consider one chain is the degenerate n=1 alkyl group ‘methyl’ while the other sidechain is varied in length.

Accordingly when the second sidechain comprises a methyl group, i.e. an alkyl group where n=1, the pyrrolidinium molecule 2761 shown in shown in FIG. 411B is referred to as 1,1-dimethylpyrrolidinium with the cation denoted as [(DMe)Pyrr]⁺. Increasing the alkyl group length to n=2 results in 1-ethyl-3-methylpyrrolidinium 2762 denoted as cation [Et(MePyrr)]⁺. For the n=3 variant 1-propyl-3-methylpyrrolidinium 2763a aka cation [Pr(MePyrr)]⁺, the extended length sidechain enhances electrochemical activity without destabilizing the ionic liquid.

The molecule's isomer, 1-isopropyl-3-methylpyrrolidinium 2763b comprising the cation [iPr(MePyrr)]⁺ is shown in FIG. 411C along with the n=4 butyl variant 1-butyl-3-methylpyrrolidinium [Bu(MePyrr)]⁺ 2764 and the pentyl sidechain 1-pentyl-3-methylpyrrolidinium [(H(H₂C)₅)(MePyrr)]⁺ 2765. An abridged list of pyrrolidinium compounds and their associated cation symbols are described in the table below: Although pyrrolidinium ionic liquids may be formed with both monovalent and multivalent anions, they are more frequently found in ILs formed with multivalent anions due to their ability to stabilize higher charge densities.

| Category | IL Cation Chemical Compound | Cation Symbol | Exemplary Anions |
|---|---|---|---|
| Pyrrolidinium | pyrrolidinium | [Pyrr]⁺ | [SO₄]²⁻, [PO₄]³⁻, |
| | N-alkyl-N-methylpyrrolidinium | [CₙMePyrr]⁺ | [CO₃]²⁻, [C₂O₄]²⁻ |
| | N,N-dimethylpyrrolidinium | [DMePyrr]⁺ | [CrO₄]²⁻, [Cr₂O₇]²⁻, |
| | N-ethyl-N-methylpyrrolidinium | [EtMePyrr]⁺ | [MoO₄]²⁻, [WO₄]²⁻, |
| | N-propyl-N-methylpyrrolidinium | [PMePyrr]⁺ | [C₄H₄O₆]²⁻, [SiO₄]⁴⁻, |
| | N-butyl-N-methylpyrrolidinium | [BuMePyrr]⁺ | [FSI]⁻, [TfSI]⁻, [OAc]⁻, |
| | N-isobutyl-N-methylpyrrolidinium | [iBuMePyrr]⁺ | [OFm]⁻, [Mal]²⁻, |
| | N-octyl-N-methylpyrrolidinium | [C₆MePyrr]⁺ | [(FH)ₙ[F]⁻, [BF₄]⁻, |
| | N-decyl-N-methylpyrrolidinium | [C₁₀MePyrr]⁺ | [NO₃]⁻, [HSO₄]⁻ |
| | N,N-dimethylpyrrolidinium | [DMePyrr]⁺ | [HCOO]^{≠}, [CH₃COO]⁻, |
| | N-diethyl-N-methylpyrrolidinium | [(DEt]MePyrr]⁺ | [CF₃COO]⁻, |
| | | | [C₇H₁₅COO]⁻ |

### Pyridinium ILs.

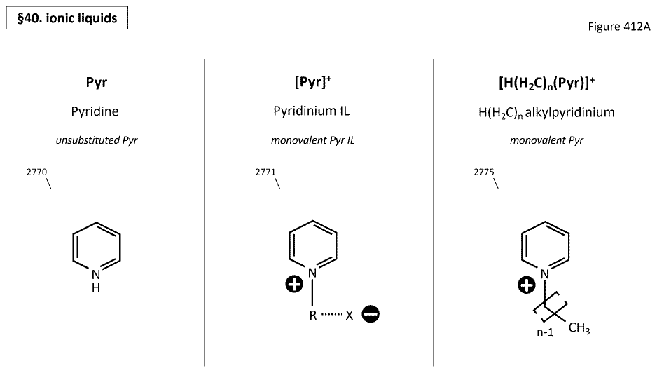

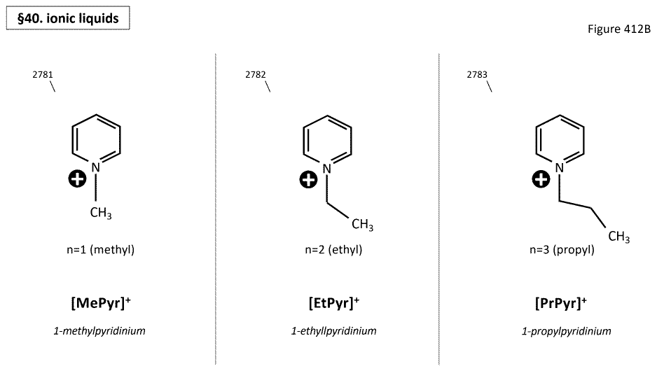

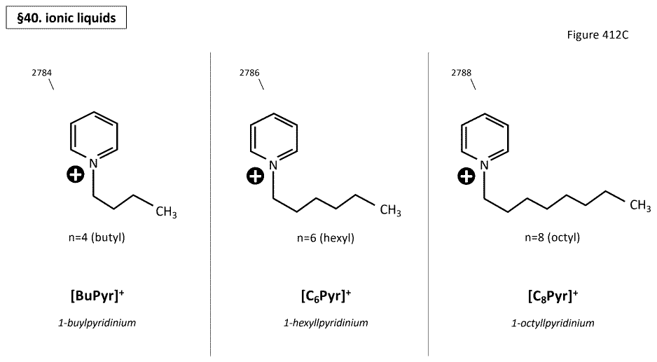

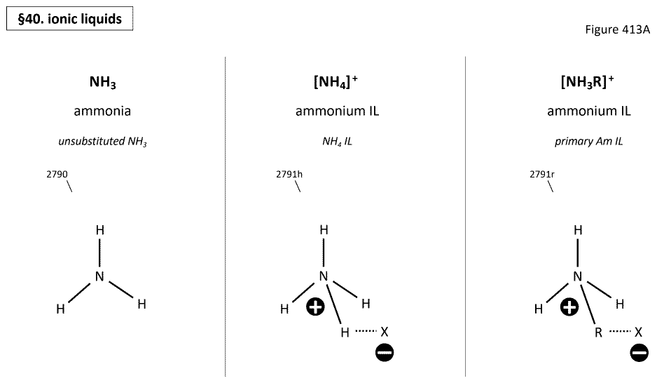

Pyridinium is the conjugate acid of pyridine (Pyr) and the cation [Pyr]⁺ of pyridinium ionic liquids. Its basis, pyridine or Pyr 2770 shown in FIG. 412A is an charge-neutral structural variant of benzene with one methine group (═CH—) replaced by a nitrogen atom (═N—). So while pyridine is represented chemically as C₅H₅N, the cation pyridinium [Pyr]⁺ includes an added ionized hydrogen chemically represented as [C₅H₅NH]⁺. Formation of pyridinium generally involves the treatment of pyridine with acids. One noteworthy item, pyridinium also comprises the main structural component of nicotinamide adenine dinucleotide (NAD), a fundamental component of redox reactions in living organisms. In accordance with Hückel's rule, pyridinium comprises an aromatic cyclic ring with a single on-ring nitrogen substitution attached to a single side group R forming monovalent pyridinium ionic liquid [Pyr]⁺ 2771 with a corresponding anion [X]⁺.

The most common side groups of monovalent pyridinium 2771 comprise alkyl groups of varying lengths ‘n’, generically called N-alkylpyridinium. N-alkylpyridinium 2775 chemically denoted as H(H₂C)ₙ or [H(H₂C)ₙ(Pyr)]⁺ describes a monovalent hydrocarbon chain (H₂C)ₙ of length ‘n’ attached to the pyridinium cyclic core. N-alkylpyridinium therefore represents a generic class of molecules following the methyl-ethyl-propyl-isopropyl-butyl naming convention (MEPIB) for increasing n lengths as described in the following table:

| n | alkyl prefix | linear formula | Pyrr cation | abbreviation |
|---|---|---|---|---|
| 1 | N-methyl | —CH₃ | 1-methylpyridinium | [MePyr]⁺ |
| 2 | N-ethyl | —(CH₂)CH₃ | 1-ethylpyridinium | [EtPyr]⁺ |
| 3 | N-propyl | —(CH₂)₂CH₃ | 1-propylpyridinium | [PrPyr]⁺ |
| 3 | iso-propyl | —CH(CH₃)₂ | 1-isopropylpyridinium | [i-PrPyr]⁺ |
| 4 | N-butyl | —(CH₂)₃CH₃ | 1-butylpyridinium | [BuPyr]⁺ |
| 4 | iso-butyl | —(CH₂)CH(CH₃)₂ | 1-isobutylpyridinium | [i-BuPyr]⁺ |
| 4 | sec-butyl | —CH(CH₃)(CH₂)CH₃ | 1-secbutylpyridinium | [s-BuPyr]⁺ |
| 4 | tert-butyl | —C(CH₃)₃ | 1-tertbutylpyridinium | [t-BuPyr]⁺ |
| 5 | N-pentyl | —(CH₂)₄CH₃ | 1-pentyllpyridinium | [C₅Pyr]⁺ |
| 5 | tert-pentyl | —C(CH₃)₂(CH₂)CH₃ | 1-tertpentyllpyridinium | [t-C₅Pyr]⁺ |
| 6 | N-hexyl | —(CH₂)₅CH₃ | 1-hexylpyridinium | [C₆Pyr]⁺ |
| 7 | N-heptyl | —(CH₂)₆CH₃ | 1-heptylpyridinium | [C₇Pyr]⁺ |
| 8 | N-octyl | —(CH₂)₇CH₃ | 1-octylpyridinium | [C₈Pyr]⁺ |
| 10 | N-decyl | —(CH₂)₉CH₃ | 1-decylpyridinium | [C₁₀Pyr]⁺ |

Several examples of varying length alkyl groups are depicted in FIG. 412B. In the degenerate case where n=1, cation N-methylpyridinium [C₅H₅NMe]⁺ 2781 comprises a single carbon three-hydrogen sidechain CH₃ commonly referred to as a methyl group. For n=2, the side group represents an ethyl group forms the molecule 1-ethyllpyridinium 2782, where the cation is abbreviated as [EtPyr]⁺. For n=3, the side group represents either a linear propyl group depicted as 1-propylpyridinium [PrPyr]⁺ 2783 or a branched isopropyl group (not shown).

In FIG. 412C, 1-buylpyridinium or [BuPyr]⁺ 2784 represents the linear butyl sidechain form for n=4. The branched versions isobutyl, sec-butyl, and tert-butyl (not shown) also follow the standard alkyl convention but are not linear in construction. Longer chains include exemplary molecules 1-hexyllpyridinium 2786 abbreviated [C₆Pyr]⁺, and 1-octyllpyridinium 2788 abbreviated [C₈Pyr]⁺. It should be noted these chemical abbreviations are simplified for convenience and more accurately are described as —(CH₂)₅CH₃ or —H(CH₂)₆ for n=6 and —(CH₂)₇CH₃ or −H(CH₂)₈ for n=8.

An exemplary list of common pyridinium based ionic liquids are described in the following table including the aforementioned alkyl groups. The following table describes a variety of pyridinium ionic liquid combinations.

| Category | IL Cation Chemical Compound | Cation Symbol | Exemplary Anions |
|---|---|---|---|
| Pyridinium | pyridinium | [Pyr]⁺ | [Br]⁻ [FSI]⁻, [TfSI]⁻, |
| | 1-alkylpyridinium | [CₙPyr]⁺ | [OAc]⁻, [OFm]⁻, |
| | 1-methylpyridinium | [MePyr]⁺ | [Mal]²⁻, [(FH)ₙF]⁻, |
| | 1-ethylpyridinium | [EtPyr]⁺ | [BF₄]⁻, [NO₃]⁻, |
| | 1-propylpyridinium | [PrPyr]⁺ | [HSO₄]⁻ [HCOO]⁻, |
| | 1-butylpyridinium | [BuPyr]⁺ | [CH₃COO]⁻, |
| | 1-isobutylpyridinium | [i-BuPyr]⁺ | [CF₃COO]⁻, |
| | 1-pentyllpyridinium | [C₆Pyr]⁺ | [C₇H₁₅COO]⁻ |
| | 1-hexylpyridinium | [C₆Pyr]⁺ | |
| | 1-octylpyridinium | [C₈Pyr]⁺ | |
| | 1-butyl-3,5-dimethylpyridinium | [Bu(DMe)Pyr]⁺ | |

It should be noted however that other pyridinium cations may also be synthesized by attaching sidechains onto carbon atoms of the cyclic ring. One example is 1-butyl-3,5-dimethylpyridinium which in addition to a n=4 butyl group attached to the nitrogen in the 1-position, it also include two additional methyl groups, i.e. dimethyl, attached to carbon in the 3- and 5-positions. As pyridinium more readily form salts with low melting temperatures comprising monovalent anions, for clarity's sake examples of multivalent anions are excluded from the table.

### Ammonium ILs.

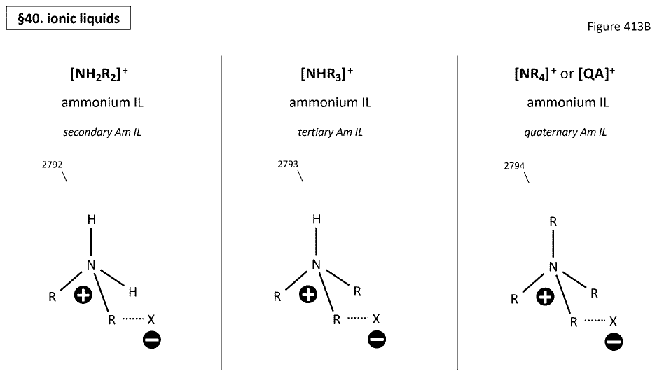

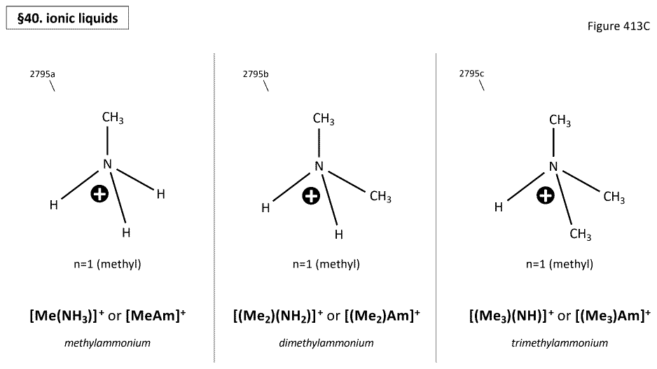

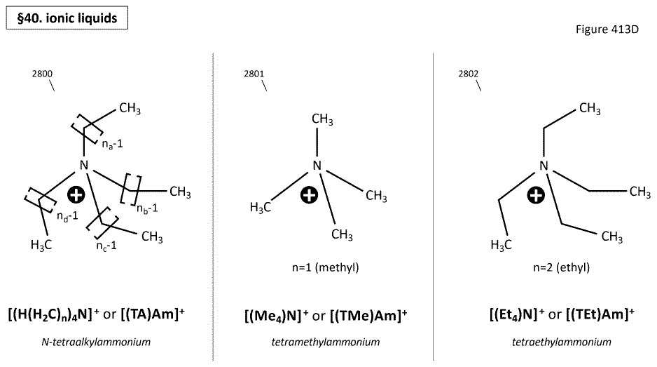

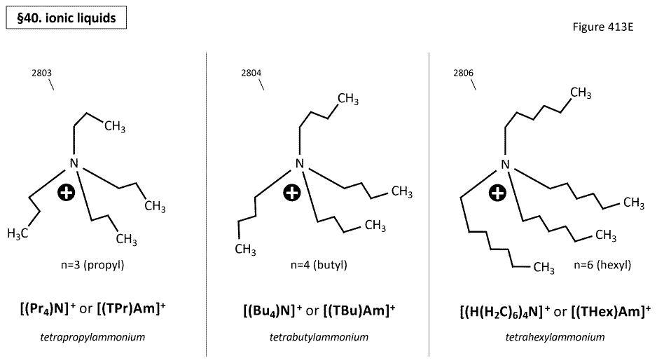

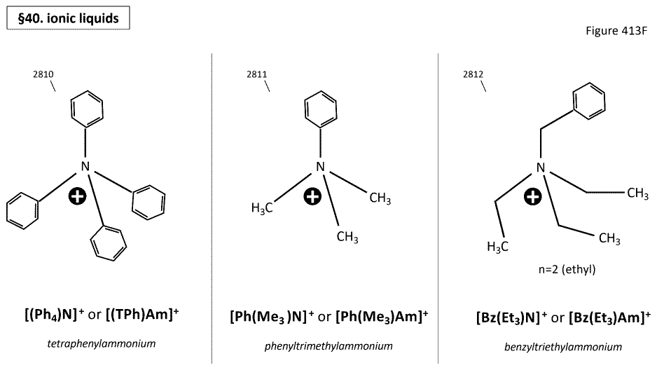

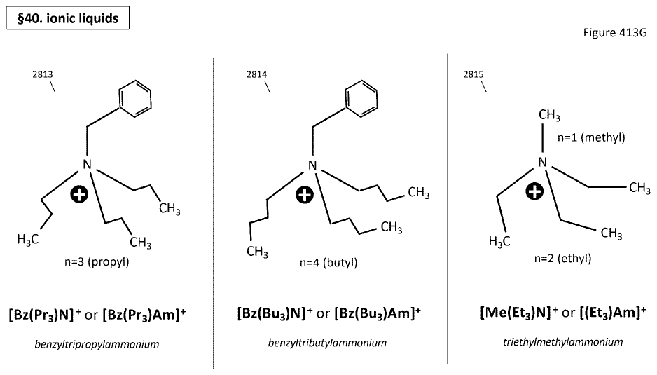

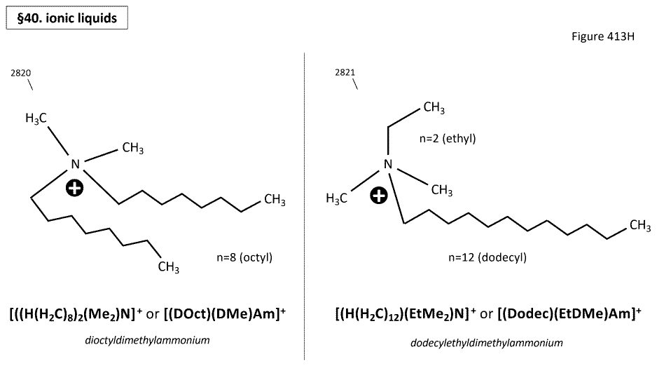

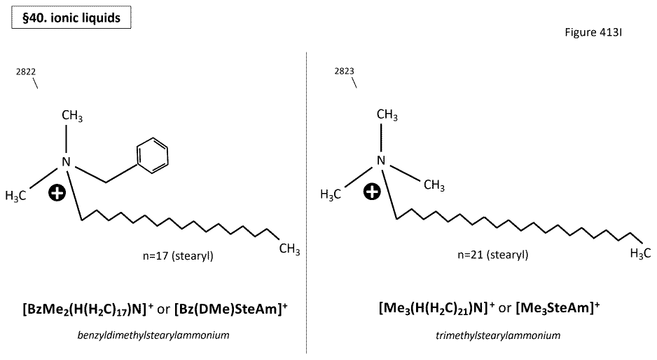

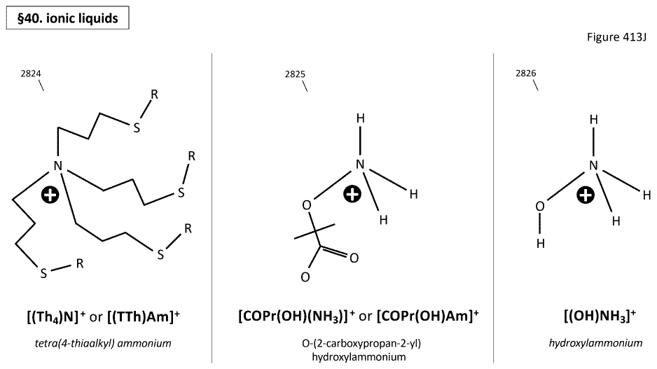

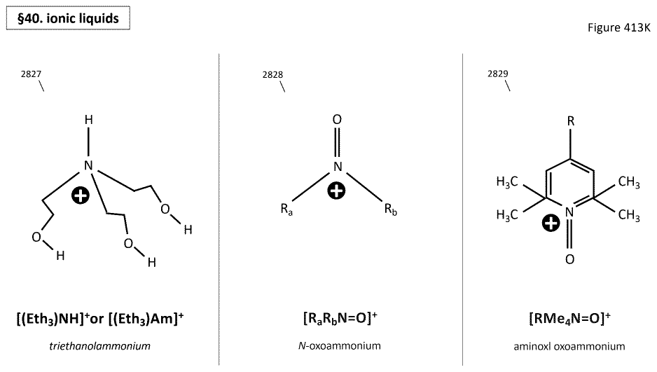

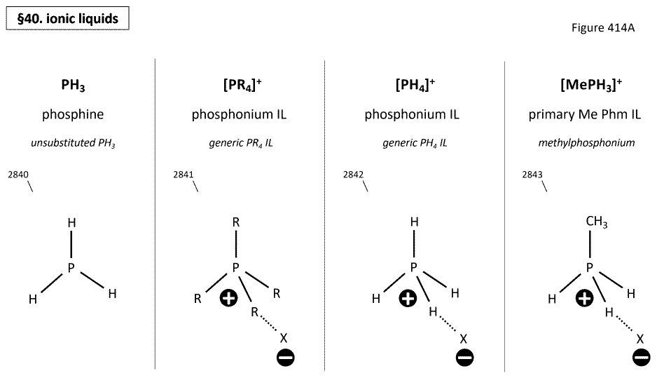

A far more diverse spectrum of ionic liquids is facilitated using the ammonium cation. Ammonium represents protonated variants of the ammonia molecule NH₃ 2790 shown in FIG. 413A. The protonation may comprise a single ionized hydrogen atom or a radical R with a monovalent charge. For example, in ionic liquids 2791h containing a primary ammonium ionic cation having the formula [NH₄]⁺, the ammonium molecule comprises a neutral NH₃ ammonia molecule with the addition of an extra hydrogen. Alternatively the extra proton may be donated by another radical R forming a primary ammonium ionic liquid 2791r where the cation is designated formulaically as [NH₃R]⁺. By this vernacular, the ammonium ionic cation [NH₄]⁺ is a special case of primary ammonium cation [NH₃R]⁺ with the substitution [R]⁺=[H]⁺.

As shown in FIG. 413B protonated ammonium may also include one to three additional charge neutral radical substitutions. For example in a secondary ammonium ionic liquid 2792, two hydrogens of ammonium cation [NH₄]⁺ are replaced with radicals R, one charged, one neutral producing the monovalent cation [NH₂R₂]⁺. In a tertiary ammonium ionic liquid 2793, three hydrogens of ammonium cation [NH₄]⁺ are replaced with radicals R, one charged, two neutral producing the monovalent cation [NHR₃]⁺.

In a quaternary ammonium ionic liquid 2794, all four hydrogens atoms are replaced by radicals R resulting in the ubiquitous monovalent cation quaternary ammonium [NR₄]⁺ also designated as [QA]⁺. Although all the four radicals R may comprise identical carbon chains, the radicals may also differ resulting in a cation formula [NRₐR_{b}R_{c}R_{d}]⁺. Note that the degenerate case of quaternary ammonium [NR₄]⁺ where [R]⁺=[H]⁺ reverts to the standard ammonium cation [NH₄]⁺. Aside from cases where the side groups compete with one another ionically, in general any combination of radicals may occur.

For example, three groups may be identical with one different, or two groups of identical radicals may occur. These variants are illustrated by example in FIG. 413C for various combinations of hydrogen [H]⁺ and methyl [Me]⁺ groups. The methylammonium cation 2795a abbreviated as [Me(NH₃)]⁺ or [MeAm]⁺ comprises a central nitrogen attached to three hydrogens and one n=1 methyl group. The dimethylammonium cation 2795b abbreviated as [(Me₂)(NH₂)]⁺ or [(Me₂)Am]⁺ comprises a central nitrogen attached to two hydrogens and two n=1 methyl groups. The trimethylammonium cation 2795c abbreviated as [(Me₃)(NH)]⁺ or [(Me₃)Am]⁺ comprises a central nitrogen attached to one hydrogen and three n=1 methyl groups.

As shown in FIG. 413D the family of ammonium cations comprising alkyl side groups can be represented in generic form as a central nitrogen with four alkyl sidechains of distinct lengths nₐ, n_{b}, n_{c}, and n_{d}. When all four radicals R are identical, the ammonium cation's side groups are generally labelled by the prefix ‘tetra” to identify their number. For example when nₐ=n_{b}=n_{c}=n_{d}=n, the resulting cation N-tetraalkylammonium 2800 can be abbreviated as [(H(H₂C)ₙ)₄N]⁺ or [(TA)Am]⁺.

Specifically when n=1, each side group comprises a single carbon and three hydrogens, i.e. methyl groups. The resulting cation tetramethylammonium 2801 may be abbreviated as [(Me₄)N]⁺ or [(TMe)Am]⁺. When n=2, each of four ethyl side groups comprising a CH₃ terminus with a single intervening CH₂ attach to a central nitrogen to form tetraethylammonium 2802 abbreviated as [(Et₄)N]⁺ or [(TEt)Am]⁺.

As shown in FIG. 413E when n=3, each of four propyl side groups attach to a central nitrogen to form the cation tetrapropylammonium 2803 abbreviated as [(Pr₄)N]⁺ or [(TPr)Am]⁺. Similarly for n=4, four butyl side groups form tetrabutylammonium 2804 abbreviated [(Bu₄)N]⁺ or [(TBu)Am]⁺ while for n=6, four hexyl side groups form tetrahexylammonium 2806. Because of the ambiguity of the hex abbreviation with hydrogen, the abbreviation for tetrahexylammonium is preferably [(H(H₂C)₆)₄N]⁺ or otherwise [(THex)Am]⁺.

Rather than side groups of alkyl, or more side groups may comprise phenyl or benzene rings. For example, in FIG. 413F, tetraphenylammonium 2810 abbreviated [(Ph₄)N]⁺ or [(TPh)Am]⁺ comprises four phenyl groups. By contrast the cation phenyltrimethylammonium 2811 [Ph(Me₃)N]⁺ or [Ph(Me₃)Am]+ comprises three methyl groups (n=1) and one phenyl group. By inserting one CH₂ into the bond between the cyclic ring and the center nitrogen, the phenyl group is referred to as a benzene group. Combining benzene with three ethyl (n=2) groups, monovalent cation benzyltriethylammonium 2812 has the abbreviations [Bz(Et₃)N]⁺ or [Bz(Et₃)Am]⁺.

As depicted in FIG. 413G, this mix-and-match ammonium cation can be substituted with a blend of benzene and three n=3 alkyl (propyl) groups such as benzyltripropylammonium 1813 [Bz(Pr₃)N]⁺ aka [Bz(Pr₃)Am]⁺, or a blend of benzene and three n=4 alkyl, i.e. butyl, groups shown as benzyltributylammonium 2814 [Bz(Bu₃)N]⁺ or [Bz(Bu₃)Am]⁺. Other heterogenous combinations include a blend of methyl (n=1) and ethyl (n=2) sidechains such as triethylmethylammonium 2815 abbreviated as [Me(Et₃)N]⁺ or [(Et₃)Am]⁺.

A mix of short chain and long chain side groups are also possible. As depicted in FIG. 413H, dioctyldimethylammonium 2820, combines two methane groups, i.e. DMe, and two octyl (n=8) groups. As such, the chemical abbreviations [((H(H₂C)₅)₂(Me₂)N]⁺ or [(DOct)(DMe)Am]⁺ are not so compact or insightful. The same complexity is true for dodecylethyldimethylammonium 2821, a combination of two (n=1) methyl groups, one (n=2) ethyl group, and a (n=12) dodecyl group. The corresponding abbreviations are [(H(H₂C)₁₂)(EtMe₂)N]⁺ or [(Dodec)(EtDMe)Am]⁺.

Other longer chain examples shown in FIG. 413I include benzyldimethylstearylammonium 2822 comprising one phenyl group, two methyl groups, and a long chain comprising 17 linearly arranged carbons. Similarly trimethylstearylammonium 2823 comprise three methyl groups and a n=21 length carbon chain.

Other ammonium variants depicted in FIG. 413J include sulfur cation tetra(4-thiaalkyl) ammonium 2824, carboxy compound O-(2-carboxypropan-2-yl)hydroxylammonium 2825, and hydroxylammonium 2826 combining the hydrogens and one OH hydroxyl group. Other oxy variants of ammonium are shown in FIG. 413K comprising triethanolammonium 2827, N-oxoammonium 2828, and aminoxl oxoammonium 2829.

These various cations combined with an expansive list of anions produce an inexhaustible list of ionic liquid candidates, each with differing physical and electrical properties. The table below list some of these possible combinations: As ammonium cations are versatile in the bonds with which they form ionic salts, ammonium anions include both monovalent and multivalent anions.

| Category | IL Cation Chemical Compound | Cation Symbol | Exemplary Anions |
|---|---|---|---|
| Ammonium | ammonium | [NH₄]⁺ | [Cl]⁻, [FSI]⁻, [TfSI]⁻, |
| | primary ammonium | [NH₃R]⁺ | [Tf₂N]⁻, [MeSO₃]⁻, |
| | secondary ammonium | [NH₂R₂]⁺ | [I]⁻, [Br₃]⁻, [NO₃]⁻, |
| | tertiary ammonium | [NHR₃]⁺ | [SO₄]²⁻, [HSO₄]⁻, |
| | quaternary ammonium | [NR₄]⁺, [QA]⁺ | [PO₄]³⁻, [HPO₄]²⁻, |
| | methylammonium | [MeNH₃]⁺, [MeAm]⁺ | [H₂PO₄]⁻, [HCOO]⁻ |
| | dimethylammonium | [Me₂NH₂]⁺, [Me₂Am]⁺ | [CH₃COO]⁻, [BF₄]⁻ |
| | trimethylammonium | [Me₃NH]⁺, [Me₃Am]⁺ | [CF₃SO₃]⁻, [PF₆]⁻, |
| | tetraalkylammonium | [TAA]⁺, [(H₂Cn)₄N]⁺ | [N(CN)₂]⁻, [SCN]⁻, |
| | tetramethylammonium | [Me₄N]⁺, [TMeAm]⁺ | [ClO₄]⁻, [CF₃COO]⁻, |
| | tetraethylammonium | [Et₄N]⁺, [TEtAm]⁺ | [(FSO₂)₂N]⁻, [CrO₄]²⁻ |
| | tetrapropylammonium | [Pr₄N]⁺, [TPrAm]⁺ | [SO₄]²⁻, [PO₄]³⁻, |
| | tetrabutylammonium | [Bu₄N]⁺, [TBuAm]⁺ | [CO₃]²⁻, [C₂O₄]²⁻, |
| | tetrahexylammonium | [H(H₂C₆)₄N]⁺, [THexAm]⁺ | [Cr₂O₇]²⁻, [MoO₄]²⁻, |
| | tetraoctylammonium | [H(H₂C₈)₄N]⁺, [TOctAm]⁺ | [WO₄]², [C₄H₄O₆]²⁻, |
| | tetradecylammonium | [H(H₂C₁₀)₄N]⁺, [TDecAm]⁺ | [SiO₄]⁴⁻, [S₂O₃]²⁻, |
| | tetraphenylammonium | [Ph₄N]⁺, [TPhAm]⁺ | [SeO₄]²⁻, [S₂O₈]²⁻, |
| | phenyltrimethylammonium | [PhMe₃N]⁺, [PhMe₃Am]⁺ | [VO₄]³⁻, [AsO₄]³⁻, |
| | benzyltriethylammonium | [BzEt₃N]⁺, [BzEt₃Am]⁺ | [BO₃]³⁻, [Fe(CN)₆]³⁻, |
| | benzyltributylammonium | [BzBu₃N]⁺, [BzBu₃Am]⁺ | [Fe(CN)₆]⁴⁻, [P₂O₇]⁴⁻, |
| | benzyltripropylammonium | [BzPr₃N]⁺, [BzPr₃Am]⁺ | [MnO₄]²⁻ |
| | triethylmethylammonium | [Et₃MeN]⁺, [Et₃MeAm]⁺ | |
| | dioctyldimethylammonium | [((H(H₂C)₈)₂MezN]⁺, | |
| | | [DOctDMeAm]⁺ | |
| | dodecylethyldimethylammonium | [(H(H₂C)₁₂)EtMe₂N]⁺, | |
| | | [DodecEtDMeAm]⁺ | |
| | benzyldimethylstearylammonium | [BzMe₂(H(H₂C)₁₇)N]⁺, | |
| | | [Bz(DMe)SteAm]⁺ | |
| | trimethylstearylammonium | [Me₃(H(H₂C)₂₁)N]⁺, | |
| | | [Me₃SteAm]⁺ | |
| | tetra(4-thiaalkyl)ammonium | [Th₄N]⁺, [TThAm]⁺ | |
| | O-(2-carboxypropan-2-yl) | Cpr(OH)NH₃]⁺, | |
| | hydroxylammonium | [Cpr(OH)Am]⁺ | |
| | hydroxylammonium | [NH₃OH]⁺ | |
| | ethanolammonium | [EthAm]⁺ | |
| | diethanolammonium | [DEthAm]⁺ | |
| | triethanolammonium | [Eth₃Am]⁺ | |
| | triethylammonium | [Et₃N] or [Et₃Am]⁺ | |
| | tributylammonium | [Bu₃Am]⁺ | |
| | tributylmethylammonium | [Bu₃MeA]⁺ | |
| | trimethylphenylammonium | [Me₃PhA]⁺ | |
| | methyl trioctylammonium | [MeTOctA]⁺ | |
| | N,N-diethyl-N-methyl-N- | [DEtMe(MeOEt)Am]⁺ | |
| | (2methoxyethyl)ammonium | | |
| | N-oxoammonium | [RₐR_{b}N═O]⁺ | |
| | aminoxl oxoammonium | [RMe₄N═O]+ | |

### Phosphonium ILs.

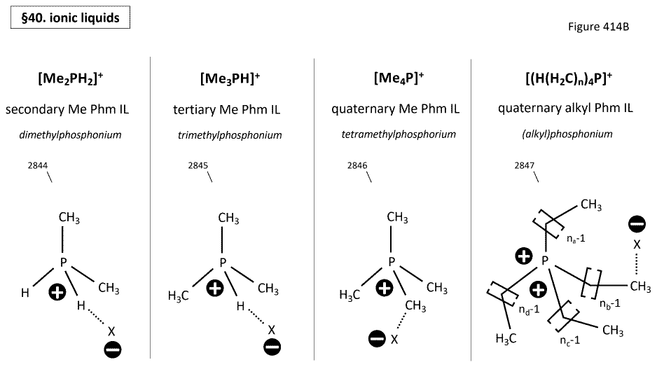

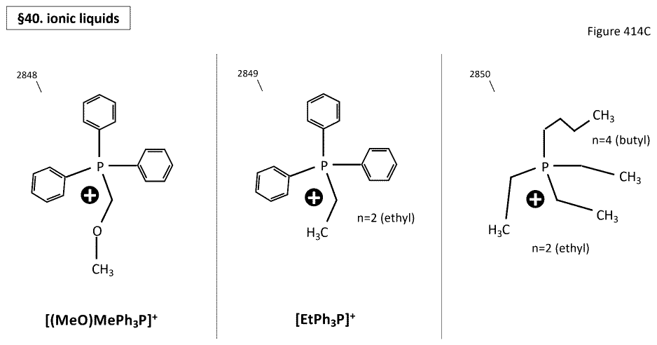

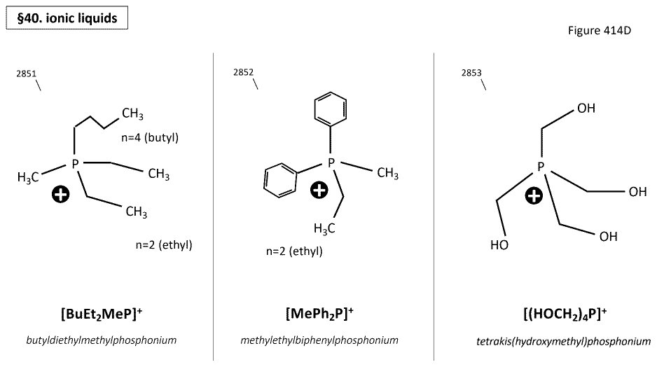

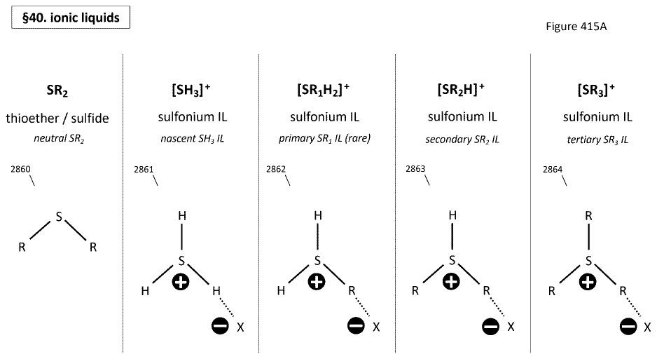

Structurally similar to the aforementioned ammonium cation, phosphonium derived from phosphine comprises a central phosphorus (rather than nitrogen) core having the chemical formula PR₄⁺ where R is hydrogen or an alkyl, aryl, or halide group. As depicted in FIG. 414A, the protonation pf phosphine PH₃ 2840 results in the generic quaternary cation [PR₄]+ which readily forms ionic liquids 2841 with anions [X]⁻. In the event where the radicals comprise hydrogen, the resulting cation 2842 may be referred to chemically by the formulation [PH₄]⁺. If one hydrogen is substituted by a methyl group, it forms the primary methylphosphonium cation 2843 [MePH₃]⁺. Because only one group is substituted the phosphonium cation is referred to as a primary cation.

As shown in FIG. 414B, if two hydrogen side groups are substituted by CH₃ (methyl) groups, the molecule is referred to as a secondary cation or dimethylphosphonium 2844 abbreviated as [Me₂PH₂]⁺. If three hydrogens are substituted by methyl groups the cation is referred to as trimethylphosphonium [Me₃PH]⁺ 2845 and the ionic liquid is described as a tertiary substitution.

In the event that all four hydrogen functional groups are substituted by methyl groups the quaternary cation is referred to as tetramethylphosphorium [Me₄P]⁺ 2846. The genericized version for alkyl groups of length ‘n’ is described as (alkyl)phosphonium 2847 chemically represented as [(H(H₂C)ₙ)₄P]⁺.

Like the ammonium cations described previously, the functional sidechains of phosphonium can be substituted by one-to-four phenyl or methyl groups. As shown in FIG. 414C, methoxymethyltriphenylphosphonium 2848 abbreviated [(MeO)MePh₃P]⁺ comprises three phenyl groups and one oxidated methyl group while ethyltriphenylphosphonium 2849 [EtPh₃P]⁺ comprise three phenyl groups and a n=2 ethyl group. Another heterogenous phosphonium molecule [BuEt₃P]⁺ or butylltriethylphosphonium 2850 comprises a central phosphorus with three n=2 ethyl groups and one n=4 butyl groups.

Similar heterogenicity is evident in butylldiethylmethylphosphonium 2851 shown in FIG. 414D where [BuEt₂MeP]⁺ comprises one n=4 butyl group, two n=2 ethyl groups, and one n=1 methyl groups. Methylethylbiphenylphosphonium 2852 or [MeEtPh₂P]⁺ contains one n=1 methyl group, one n=2 ethyl group and two phenyl groups. Homogenous tetrakis(hydroxymethyl)phosphonium 2853 contains four hydroxy methyl radicals as described by its chemical composition [(HOCH₂)₄P]+.

The table below describes possible ionic liquids comprising phosphonium cations and a variety of anions which may be combined in a mix-and-match fashion. Like ammonium, phosphonium forms ionic salts and ionic liquids with both monovalent and multivalent anions, a sample of which are included in the below table. Except for the pristine radical itself abbreviated [Phosm]⁺, cation symbols for all the phosphonium ions are represented by the letter ‘P’ which should be understood contextually to mean phosphonium and not elemental phosphorus.

| Category | IL Cation Chemical Compound | Cation Symbol | Exemplary Anions |
|---|---|---|---|
| Phosphonium | phosphonium | [Phosm]⁺ | [Cl]⁻, [Tf₂N]⁻, [Br]⁻, [FSI]⁻, |
| | triethylhexylphosphonium | [Et₃HexP]⁺ | [TfSI]⁻, [F]⁻[NO₃]⁻, |
| | triethylbenzylphosphonium | [3EtBzP]⁺ | [MeSO₃]⁻, [I]⁻, [Br₃]⁻, |
| | tributylmethylphosphonium | [3BuMeP]⁺ | [NO₃]⁻, [SO₄]²⁻, [HSO₄]⁻, |
| | triisobutylmethylphosphonium | [3iBuMeP]⁺ | [PO₄]³⁻, [HPO₄]²⁻, |
| | trioctylmethylphosphonium | [3OctMeP]⁺ | [H₂PO₄]⁻, [HCOO]⁻ |
| | trihexyltetradecylphosphonium | [3HTDP]⁺ | [CH₃COO]⁻, [BF₄]⁻ |
| | trihexylmethylphosphonium | [3HMeP]⁺ | [CF₃SO₃]⁻, [PF₆]⁻, |
| | triisopropylmethylphosphonium | [3(iPr)MeP]⁺ | [N(CN)₂]⁻, [SCN]⁻, |
| | tetraethylphosphonium | [TEtP]⁺ | [ClO₄]⁻, [CF₃COO]⁻, |
| | tetrabutylphosphonium | [TBuP]⁺ | [(FSO₂)₂N]⁻, [NTf₂], |
| | tetraphenylphosphonium | [TPhP]⁺ | [ClO₄]⁻, [CrO₄]²⁻ [SO₄]²⁻, |
| | | | [PO₄]³⁻, [CO₃]²⁻, [C₂O₄]²⁻, |
| | | | [Cr₂O₇]²⁻, [MoO₄]²⁻, |
| | | | [WO₄]², [C₄H₄O₆]²⁻, |
| | | | [SiO₄]⁴⁻, [S₂O₃]²⁻, |
| | | | [SeO₄]²⁻, [S₂O₈]²⁻, [VO₄]³⁻, |
| | | | [AsO₄]³⁻, [BO₃]³⁻, |
| | | | [Fe(CN)₆]³⁻, [Fe(CN)₆]⁴⁻, |
| | | | [P₂O₇]⁴⁻, [MnO₄]²⁻ |

### Sulfonium ILs.

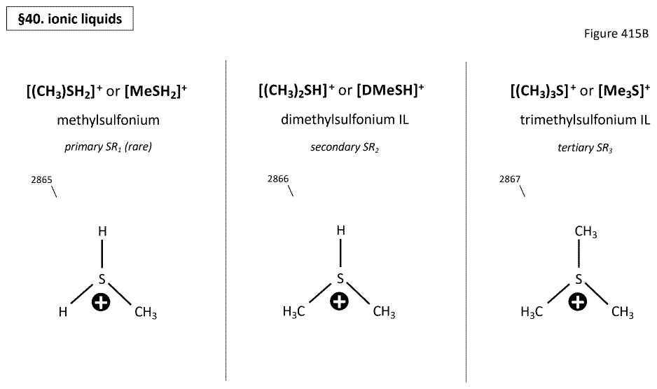

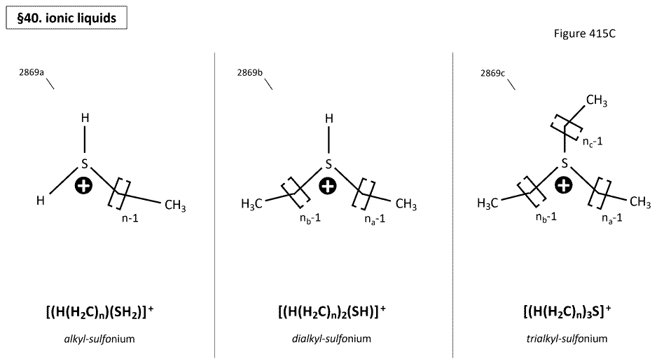

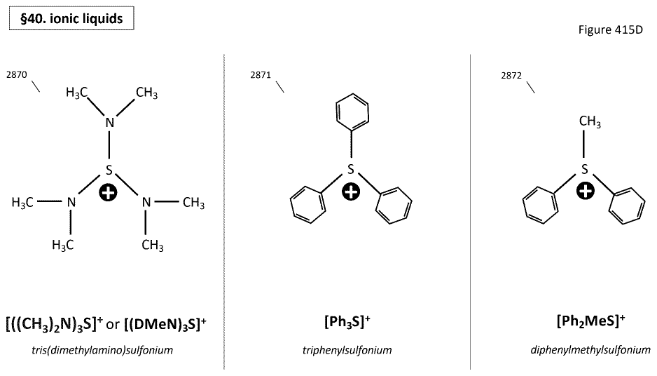

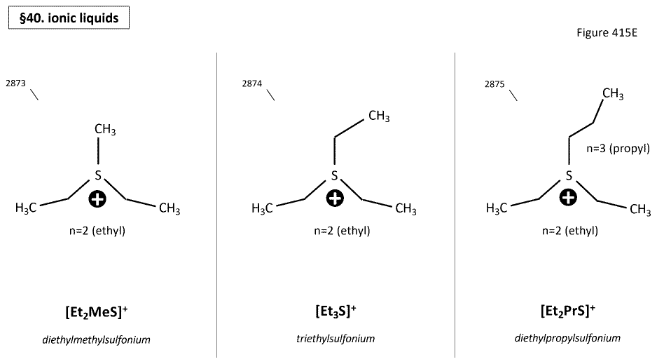

Sulfonium is a monovalent cation of sulfur, a molecular structural variant of sulfide. As shown in FIG. 415A, the charge neutral molecule sulfide 2860 comprises a central bonded to two neutral radicals with the formula SR₂. Sulfide synthesis involves acid treatment of sulfide salts S²⁻ to form hydrogen sulfide H₂S.

As an organosulfur compound with the general structural form [SH₃]⁺, the cation sulfonium 2861 comprises a protonated sulfide. Despite its structural similarity to the sulfide molecule, synthesis of sulfonium generally involves a reaction of thioethers with alkyl halides, the reaction proceeds by a nucleophilic substitution mechanism. In a single substitution reaction, one hydrogen is replaced by a radical R to form the primary sulfonium cation [SR₁H₂]⁺ 2862. A more common reaction forms a secondary sulfonium cation [SR₂H]⁺ 2863, one comprising a single sulfur central core attached to one hydrogen and two radicals. In tertiary sulfonium 2864, all three hydrogens are substituted with radical R to form the cation [SR₃]⁺.

Examples of primary, secondary, and tertiary methyl substitutions of sulfonium are shown in FIG. 415B. In the primary cation methylsulfonium 2865, a single methyl substitution results in a the chemical [(CH₃)SH₂]⁺ or [MeSH₂]⁺. In the secondary cation dimethylsulfonium 2866, two methyl substitutions result in a the chemical [(CH₃)₂SH]⁺ or [Me₂SH]⁺. In the tertiary cation trimethylsulfonium 2867, three methyl substitutions result in a the chemical [(CH₃)₃S]⁺ or [Me₃SH]⁺. Extending the substitutions to alkyl groups comprising carbon chains of length ‘n’, FIG. 415C include primary cation alkyl-sulfonium [(H(H₂C)ₙ)(SH₂)]⁺ 2869a comprising a single alkyl chain; secondary cation dialkyl-sulfonium [(H(H₂C)ₙ)₂(SH)]⁺ 2869b comprising two alkyl chains; and tertiary cation trialkyl-sulfonium [(H(H₂C)ₙ)₃S]⁺ 2869c comprising three alkyl chains.

Other variants shown in FIG. 415D include tris(dimethylamino)sulfonium 2870 having the chemical formula [((CH₃)₂N)₃S]⁺ or [(DMeN)₃S]⁺ with three dimethyl-amino chains. Phenyl sulfonium variants include triphenylsulfonium [Ph₃S]⁺ 2871 and diphenylmethylsulfonium [Ph₂MeS]⁺ 2872. Other alkyl-sulfonium combinations shown in FIG. 415E include diethylmethylsulfonium [Et₂MeS]⁺ 2873, triethylsulfonium [Et₃S]⁺ 2874, and diethylpropylsulfonium [Et₂PrS]⁺ 2875.

A list of sulfonium cations and anions for sulfonium ionic liquids is described in the table below including both monovalent and multivalent anions: As in the case described previously with sulfonium, except for the pristine radical itself abbreviated [Sulfm]⁺, cation symbols for all the sulfonium ions are represented by the letter ‘S’ which should be understood contextually to mean the compound sulfonium and not elemental sulfur.

| Category | IL Cation Chemical Compound | Cation Symbol | Exemplary Anions |
|---|---|---|---|
| Sulfonium | sulfonium | [Sulfm]⁺ | [Cl]⁻, [Tf₂N]⁻, [Br]⁻, |
| | trimethylsulfonium | [3MeS]⁺ | [FSI]⁻, [TfSI]⁻, [F]⁻ |
| | triethylsulfonium | [3EtS]⁺ | [NO₃]⁻, [MeSO₃]⁻, |
| | tripropylsulfonium | [3PrS]⁺ | [I]⁻, [Br₃]⁻, [NO₃]⁻, |
| | tributylsulfonium | [3BuS]⁺ | [SO₄]²⁻, [HSO₄]⁻, |
| | trioctylsulfonium | [3OctS]⁺ | [PO₄]³⁻, [HPO₄]²⁻, |
| | dimethylsulfonium methylide | [DMeS-Me]⁺ | [H₂PO₄]⁻, [HCOO]⁻ |
| | methylethylsulfonium | [MeES]⁺ | [CH₃COO]⁻, [BF₄]⁻ |
| | methylpropylsulfonium | [MePrS]⁺ | [CF₃SO₃]⁻, [PF₆]⁻, |
| | methylphenylsulfonium | [MePhS]⁺ | [N(CN)₂]⁻, [SCN]⁻, |
| | benzylsulfonium | [BzS]⁺ | [ClO₄]⁻, [CF₃COO]⁻, |
| | | | [FSO₂)₂N]⁻, [NTf₂]⁻, |
| | | | [ClO₄]⁻, [CrO₄]²⁻ |
| | | | [SO₄]²⁻, [PO₄]³⁻ |
| | | | [CO₃]²⁻, [C₂O₄]²⁻, |
| | | | [Cr₂O₇]²⁻, [MoO₄]²⁻, |
| | | | [WO₄]², [C₄H₄O₆]²⁻, |
| | | | [SiO₄]⁴⁻, [S₂O₃]²⁻, |
| | | | [SeO₄]²⁻, [S₂O₈]²⁻, |
| | | | [VO₄]³⁻, [AsO₄]³⁻, |
| | | | [BO₃]³⁻, [Fe(CN)₆]³⁻, |
| | | | [Fe(CN)₆]⁴⁻, [P₂O₇]⁴⁻, |
| | | | [MnO₄]²⁻ |

### Thiaizolium ILs.

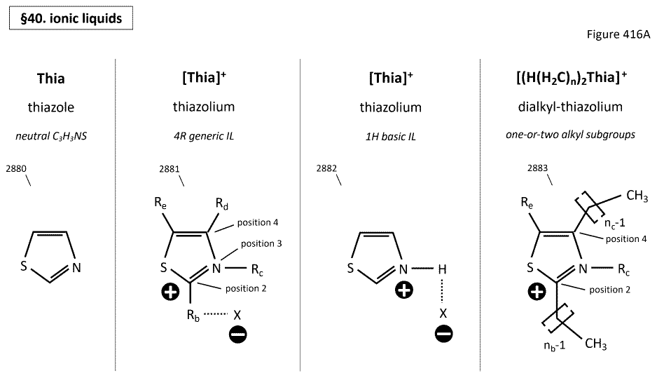

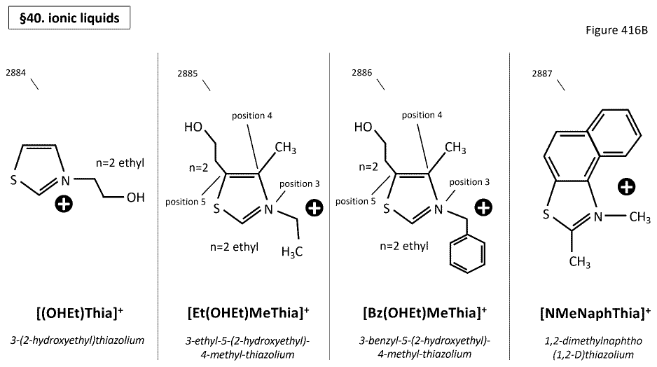

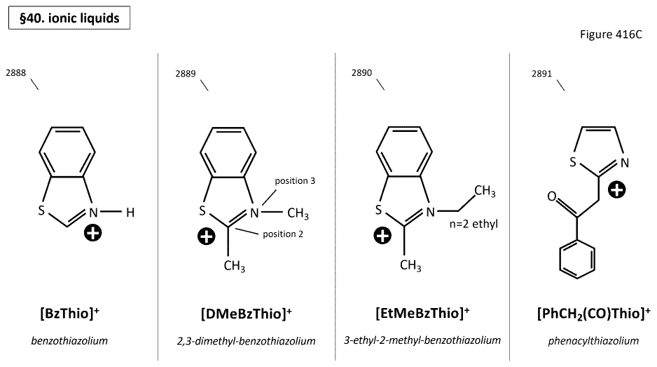

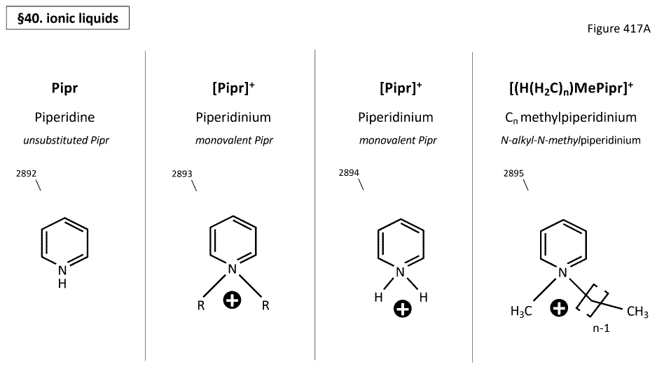

As shown in FIG. 416A, thiazolium 2681 is a protonated version of thiazole 2880, a cyclic neutral molecule of composition C₃H₃NS. Monovalent thiazolium [Thia]⁺ 2681 as depicted includes four radical sidechains, along with a single hydrogen sidechain variant of thiazolium [Thia]⁺ 2882. As illustrated thiazolium variant dialkyl-thiazolium 2883 can support one-or-two alkyl subgroups of length ‘n, for example in positions 2 and 4 with a chemical formula [(H(H₂C)ₙ)₂Thia]⁺.

Alkyl-thiazolium cation examples shown in FIG. 416B include 3-(2-hydroxyethyl)thiazolium [(OHEt)Thia]⁺ 2884 comprising a n=2 hydroxyethyl side group; 3-ethyl-5-(2-hydroxyethyl)-4-methyl-thiazolium [Et(OHEt)MeThia]⁺ 2885 comprising two n=2 side groups and one methyl group. Variant thiazolium 2886 comprising the three sidechain 3-benzyl-5-(2-hydroxyethyl)-4-methyl-thiazolium has the formula [Bz(OHEt)MeThia]⁺. Another variant 1,2-dimethylnaphtho(1,2-D)thiazolium, chemically as [NMe(Naph)Thia]⁺ 2887 comprises three cyclic rings.

Other two-ring thiazolium cations shown in FIG. 416C comprise exemplary molecules benzothiazolium [BzThio]⁺ 2888; 2,3-dimethyl-benzothiazolium [DMeBzThio]⁺ 2889; 3-ethyl-2-methyl-benzothiazolium [EtMeBzThio]⁺ 2890; and phenacylthiazolium [PhCH2(CO)Thio]⁺ 2891.

Examples of ionic liquids based on thiazolium cations are described in the following table: The selection of anions depends on the desired materials properties. Specifically monovalent anions such as chloride, bromide, or nitrate form ionic liquids with lower melting points and better fluidity, while multivalent anions offer greater high temperature stability and lower viscosities making them easier to retain within a membrane.

| | IL Cation Chemical | Cation | |
|---|---|---|---|
| Category | Compound | Symbol | Exemplary Anions |
| Thiazolium | thiazolium | [Tz]⁺ | [Cl]⁻, [Tf₂N]⁻, [Br]⁻, |
| | methylthiazolium | [MeTz]⁺ | [FSI]⁻, [TfSI]⁻, [F]⁻ |
| | ethylthiazolium | [EtTz]⁺ | [NO₃]⁻, [MeSO₃]⁻, |
| | benzylthiazolium | [BzTz]⁺ | [I]⁻, [Br₃]⁻, [NO₃]⁻, |
| | phenylthiazolium | [PhTz]⁺ | [SO₄]²⁻, [HSO₄]⁻, |
| | allylthiazolium | [AlylTz]⁺ | [PO₄]³⁻, [HPO₄]²⁻, |
| | butylthiazolium | [BuTz]⁺ | [H₂PO₄]⁻, [HCOO]⁻ |
| | hexylthiazolium | [HTz]⁺ | [CH₃COO]⁻, [BF₄]⁻ |
| | octylthiazolium | [OctTz]⁺ | [CF₃SO₃]⁻, [PF₆]⁻, |
| | | | [N(CN)₂]⁻, [SCN]⁻, |
| | | | [ClO₄]⁻, [CF₃COO]⁻, |
| | | | [(FSO₂)₂N]⁻, [NTf₂]⁻, |
| | | | [ClO₄]⁻ |

### Piperidinium ILs.

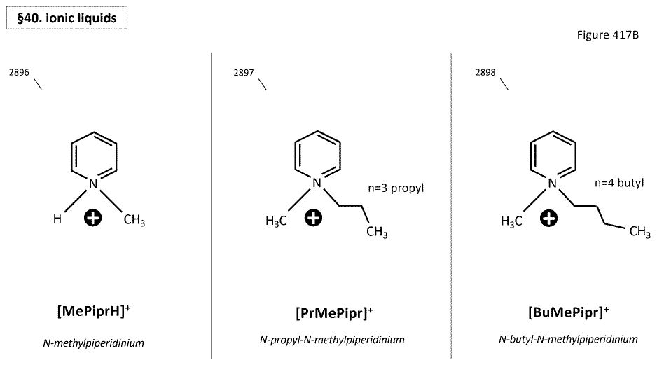

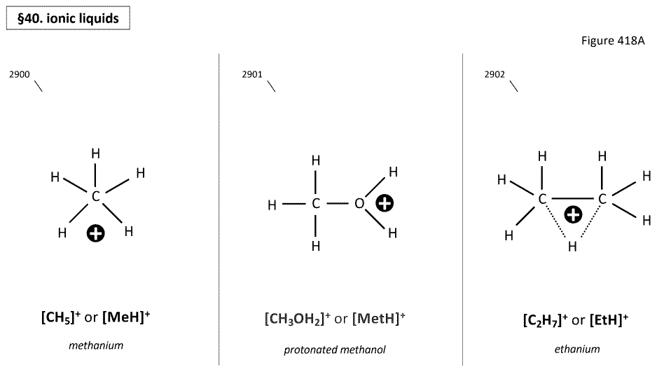

As shown in FIG. 417A, piperidinium [Pipr]⁺ 2893 is a protonated cation of the neutral cyclic molecule piperidine Pipr 2892 with two radicals R bonded to a on-ring nitrogen including the case of a two hydrogen version 2894. Cation N-alkyl-N-methylpiperidinium [(H(H₂C)ₙ)MePipr]⁺ 2895 comprises one methyl group and one alkyl chain of length ‘n’.

Examples of alkyl variants shown in FIG. 417B include N-methylpiperidinium [MePiprH]⁺ 2896 comprising one methyl group; N-propyl-N-methylpiperidinium [PrMePipr]⁺ 2897 comprising one methyl and one n=3 propyl group; and N-butyl-N-methylpiperidinium [BuMePipr]⁺ comprising one methyl group and one n=4 butyl group.

The following table summarizes piperidinium cations used in ionic liquids: Piperidinium cations are more often found in ILs with multivalent anions due to their ability to stabilize higher charge densities, properties similar to pyrrolidinium. Pyrrolidinium cations include the full MEPIB+ spectrum of linear and branching alkyl carbon chains including methyl, ethyl, propyl, isopropyl, and butyl isomers, along with longer chains. In the abbreviated cation symbol names the ion piperidinium is abbreviated as (Pip) or (PipH) depending on bonds to its cyclic ring.

| Category | IL Cation Chemical Compound | Cation Symbol | Exemplary Anions |
|---|---|---|---|
| Piperidinium | piperidinium | [PipH]⁺ | [SO₄]²⁻, [HSO₄]⁻, |
| | N-methylpiperidinium | [Me(PipH)]⁺ | [PO₄]³⁻, [HPO₄]²⁻, |
| | N,N-dimethylpiperidinium | [DMe(Pip)]⁺ | [H₂PO₄]⁻, [CO₃]²⁻, |
| | N-ethylpiperidinium | [Et(PipH)]⁺ | [C₂O₄]²⁻, [CrO₄]²⁻, |
| | N-ethyl-N-methylpiperidinium | [EtMe(Pip)]⁺ | [Cr₂O₇]²⁻, [C₄H₄O₆]²⁻ |
| | N-propylpiperidinium | [Pr(PipH)]⁺ | [C₆H₅O₇]³⁻, [BO₃]³⁻ |
| | N-propyl-N-methylpiperidinium | [PrMe(Pip)]⁺ | [Cl]⁻, [Tf₂N]⁻, [Br]⁻, |
| | N-butylpiperidinium | [Bu(PipH)]⁺ | [FSI]⁻, [TfSI]⁻, [F]⁻ |
| | N-butyl-N-methylpiperidinium | BuMe(Pip)]⁺ | [NO₃]⁻, [MeSO₃]⁻, |
| | N-pentylpiperidinium | [H(H₂C)₅(PipH)]⁺ | [I]⁻, [Br₃]⁻, [NO₃]⁻, |
| | N-pentyl-N-methylpiperidinium | [H(H₂C)₅Me(Pip)]⁺ | [SO₄]²⁻, [HSO₄]⁻, |
| | N-hexylpiperidinium | [H(H₂C)₆(PipH)]⁺ | [PO₄]³⁻, [HPO₄]²⁻, |
| | N-hexyl-N-methylpiperidinium | [H(H₂C)₈Me(Pip)]⁺ | [H₂PO₄]⁻, [HCOO]⁻ |
| | N-octypiperidinium | [H(H₂C)₈(PipH)]⁺ | [CH₃COO]⁻, [BF₄]⁻ |
| | N-octyl-N-methylpiperidinium | [H(H₂C)₈Me(Pip)]⁺ | [CF₃SO₃]⁻, [PF₆]⁻, |
| | N-decylpiperidinium | [H(H₂C)₁₀(PipH)]⁺ | [N(CN)₂]⁻, [SCN]⁻, |
| | N-decyl-N-methylpiperidinium | [H(H₂C)₁₀Me(Pip)]⁺ | [ClO₄]⁻, [CF₃COO]⁻, |
| | | | [(FSO₂)₂N]⁻, [NTf₂]⁻, |
| | | | [ClO₄]⁻, [P₂O₇]⁴⁻ |

### Protonated Hydrocarbons.

Aside from the forgoing cations, a variety of hydrocarbon compounds may form cations in ionic liquids. Hydrocarbon fuel and hydrocarbon solvent based cations are imprecisely referred to a ‘carbonium’.

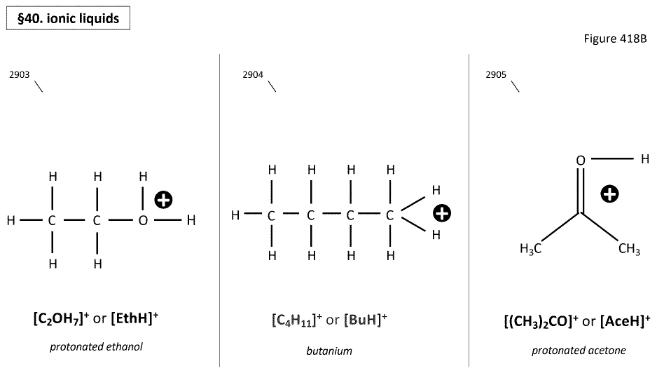

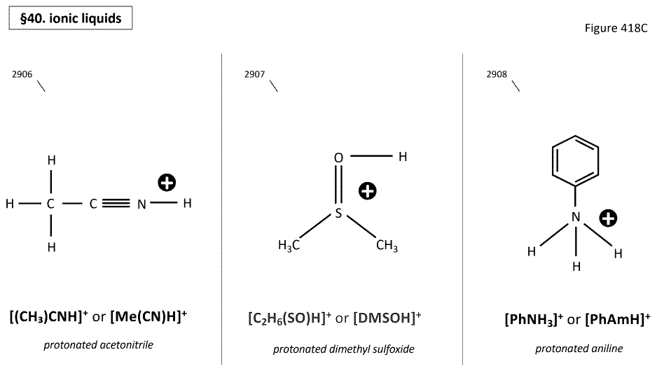

Examples shown in FIG. 418A include methanium [CH₅]⁺ or [MeH]⁺ 2900 and protonated methanol [CH₃OH₂]⁺ or [MetH]⁺ 2901. Longer chain hydrocarbons include ethanium [C₂H₇]⁺ or [EtH]⁺ 2902. FIG. 418B includes protonated ethanol 2903 having the chemical composition [C₂OH₇]⁺ or [EthH]⁺ and butanium chemically as [C₄Hu]⁺ or [BuH]⁺ 2904. Another carbonium compound is protonated acetone 2905, chemically denoted as [(CH₃)[CO]⁺ or [AceH]⁺.

FIG. 418C illustrates other hydrocarbon based ionic cations. Once such molecule is protonated acetonitrile 2906 chemically formulated as [(CH₃)CNH]C and denoted as [Me(CN)H]⁺. A simpler monovalent carbonium cation comprises protonated dimethyl sulfoxide (DMSO) 2907. With the chemical formulation [C₂H₆(SO)H]⁺, the compound may be abbreviated as [DMSOH]⁺. Another cation ‘protonated aniline’ 2908 comprises one methyl group and one phenyl aromatic ring with a composition [PhNH₃]⁺ or abbreviated as [PhAmH]⁺.

The following table of carbonium cations along with a diverse spectrum of monovalent and divalent anions are able to make a long list of hydrocarbon based ionic liquids:

| Category | IL Cation Chemical Compound | Cation Symbol | Exemplary Anions |
|---|---|---|---|
| Protonated | methanium, protonated methane | [CH₅]⁺ | [Cl]⁻, [Br]⁻, [I]⁻, [BF₄]⁻, |
| hydrocarbons | protonated methanol | [CH₃OH₂]⁺ | [PF₆]⁻, [CF₃SO₃]⁻, [F]⁻ |
| (carbonium) | ethanium, protonated ethane | [C₂H₇]⁺ | N(CN)₂]⁻, [NTf₂]⁻, [OH]⁻ |
| | protonated ethanol | [C₂H₅OH₂]⁺ | [CH₃COO]⁻, [CH₃SO₃]⁻, |
| | propanium, protonated propane | [C₃H₉]⁺ | [C₂H₅SO₃]⁻, [HCOO]⁻ |
| | protonated propanol | [C₃H₉O]⁺ | [(C₂H₅O)₂PO₂]⁻, [NO₃]⁻, |
| | butanium, protonated butane | [C₄H₁₁]⁺ | [(CH₃O)₂PO₂]⁻, [FSI]⁻, |
| | protonated butanol | [C₄H₁₁O]⁺ | [C₂H₅COO]⁻, [ClO₄]⁻ |
| | octonium, protonated octane | [C₈H₁₉]⁺ | [C₃H₇COO]⁻, [ClO₃]⁻ |
| | protonated acetone | [CH₃COH⁺CH₃]⁺ | [FSO₂N•SO₂F]⁻, [BrO₃]⁻, |
| | pronated acetic acid | [CH₃COOH₂]⁺ | [IO₃]⁻, [ClO]⁻, [OCN]⁻, |
| | protonated acetonitrile | [CH₃CNH]⁺ | [SCN]⁻, [C₂O₄)²⁻, [SiO₄]⁻, |
| | protonated dimethyl sulfoxide (DMSO) | [C₂H₆OSH]⁺ | [C₄H₄O₆]²⁻, [C₆H₅O₇]³⁻, |
| | protonated toluene | [C₇H₉]⁺ | [C₈H₄O₄]²⁻, [HCO₃]⁻, |
| | protonated aniline | [C₆H₅NH₃]⁺ | [SiO₃]²⁻, [BO₃]³⁻, [TfSI]⁻, |
| | | | [B₄O₇]²⁻, [PO₄]³⁻, [Br₃]⁻, |
| | | | [HPO₄]²⁻, [H₂PO₄]⁻, |
| | | | [NO₃]⁻, [MeSO₃]⁻, |
| | | | [WO₄]²⁻, [SO₄]²⁻, |
| | | | [ClO₄]⁻, [HSO₄]⁻, [ClO₄]⁻ |
| | | | [CF₃COO]⁻, [MnO₄]⁻ |
| | | | [(FSO₂)₂N]⁻, [C₂O₄]² |

### Biochemical ILs.

Aside from carbonium cations described previously, cations forming ionic liquids may also be derived from biochemical sources. Biochemical ionic liquids offer the prospect of exceptional biocompatibility, sustainable sourcing, low toxicity, and biodegradability while displaying beneficial physio-chemical properties including solvation capabilities, ionic conductivity, low vapor pressure, and high thermal stability.

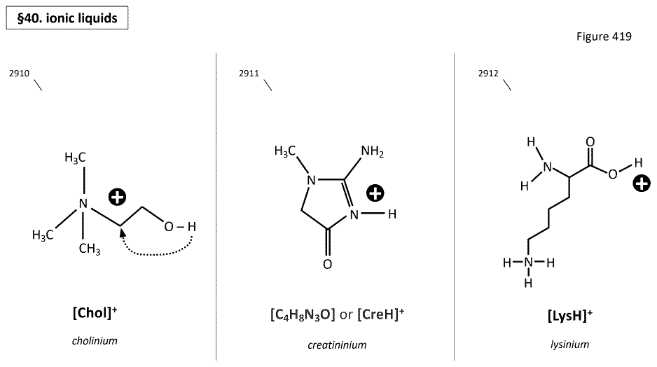

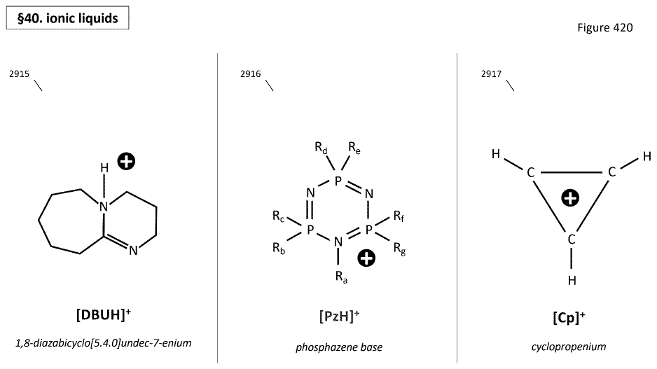

For example, in cholinium-amino acid ionic liquid, a deprotonated amino is reacted with the choline hydroxide base to form a protic ionic liquid (PIL) having cholinium as its cation. PILs represent a subclass of ionic liquids arising from an acid-base reaction or proton transfer. As shown in FIG. 419, cholinium [Chol]⁺ 2910 illustrates the cation comprising [N(CH₃)₃NCH₃CH₂O]⁺. The cation is formed from choline (CH₃)₃NCH₂CH₂OH where the terminus hydrogen forms a bond with the CH2 nearest the nitrogen core to form a fourth methyl group, essentially converting choline into a quaternary ammonium molecule but with an H₂CO formaldehyde terminus.

Creatininium 2911 comprises a protonated version of creatine having the formula [C₄H₈N₃O]abbreviated [CreH]⁺ where the extra hydrogen is nitrogen bound. A protonated version of lysine, lysinium 2912 abbreviated [LysH]⁺ has the chemical composition [C₆H₁₅N₂O₂]⁺. The following table lists exemplary biochemical ionic liquids.

| | IL Cation | | |
|---|---|---|---|
| | Chemical | | |
| Category | Compound | Cation Symbol | Exemplary Anions |
| Biochemical | carbonium | see prior table | carbonium: see prior table. |
| cations | cholinium | [Chol]⁺ | cholinium: [CH₃COO]⁻, [PF₆]⁻, |
| | creatininium | [CreH]⁺ | [H₂PO₄]⁻, [CF₃COO]⁻, [NTf₂]⁻ |
| | argininium | [ArgH]⁺ | creatininium: [Cl]⁻, [Br]⁻, [NO₃]⁻, |
| | histidinium | [HisH]⁺ | [SO₄]²⁻, [HSO₄]⁻ |
| | lysinium | [LysH]⁺ | argininium: [BF₄]⁺, [CH₃SO₃]⁻, |
| | guanidinium | [GuaH]⁺ | [H₂PO₄]⁻, [CF₃COO]⁻, [C₆H₅SO₃]⁻ |
| | | | [SO₃]⁻, [NO₃]⁻, [ClO₄]⁻, [OTf]⁻ |
| | | | histidinium: [TFA]⁻, [PF₆]⁻, |
| | | | [SCN]⁻, [ClO₄]⁻, [I]⁻ |
| | | | lysinium: [HCOO]−, [C₂O₄]²⁻, |
| | | | [PFBuS]⁻, [NTf₂]⁻, [ClO₃]⁻ |
| | | | guanidinium: [TsO]⁻, [MetSO)⁻, |
| | | | (ClO₄)⁻, (PF₆)⁻, [Tf₂N]⁻, [Cl]⁻, [I]⁻ |

### Superbase ILs.

A superbase is a chemical compound with extremely high basicity, i.e. with a strong ability to accept protons (H₊)—much stronger typical bases such as sodium hydroxide (NaOH) or potassium hydroxide (KOH). Once absorbing a ionized hydrogen, the protonated superbase is referred to as a superbase cation. Ionic liquids containing superbase cations are referred to as superbase ILs. Unlike the previously described ion liquids defined by the chemical structure of their constituent cation, superbase cations are characterized by their basicity, not their molecular structure or atomic composition. As such, superbase ILs are not specific to any one chemical family but cross structural forms.

One broad category of superbase ILs comprise quaternary ammonium cations with alkyl sidechains of varying carbons lengths including tetramethylammonium (n=1), tetraethylammonium (n=2), tetrapropylammonium (n=3), tetrabutylammonium (n=4) and longer chain moieties (not listed). Another superbase cation is the tetraphenyl variant of phosphonium, referred to as tetraphenylphosphonium.

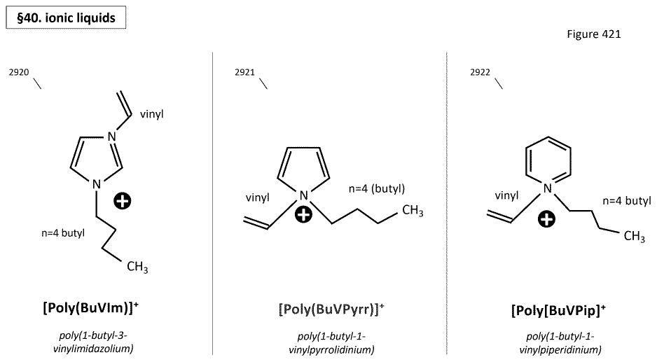

Less commonly known superbase variants shown in FIG. 420 include the monovalent cation [DBUH]⁺ chemically as 1,8-diazabicyclo[5.4.0] undec-7-enium 2915 and cyclopropenium 2917. Phosphazene 2916 also forms a large spectrum of superbase ILs as evidenced by its seven possible side groups. Tens of thousands of combinations are possible. The following table describes a variety of exemplary combinations of superbase cations and anions combined to form superbase ionic liquids:

| Category | IL Cation Chemical Compound | Cation Symbol | Exemplary Anions |
|---|---|---|---|
| Superbase | tetramethylammonium | [TMeA]⁺ | [CH₃COO]⁻, [OAc]⁻, [I]⁻, [PF₆]⁻, |
| cations | tetraethylammonium | [TEtA]⁺ | [BF₄]⁻, [Tf₂N]⁻, [CF₃SO₃]⁻, |
| | tetrapropylammonium | [TPrA]⁺ | [NO₃]⁻, [N(CN)₂]⁻, [CH₃SO₃]⁻, |
| | tetrabutylammonium | [TBuA]⁺ | [C₂H₅SO₄]⁻, [HSO₄]⁻, [Br]⁻, |
| | tetraphenylphosphonium | [TPhP]⁺ | [Cl]⁻ [ClO₄]⁻, [SCN]⁻, [HCOO]⁻, |
| | 1,8-diazabicyclo[5.4.0]undec-7-enium | [DBUH]⁺ | [CO₃]², [p-CH₃C₆H₄SO₃]⁻, |
| | 1,5,-diazabicyclo[4,3,0]non-5-enium | [DBNH]⁺ | [PO₄]³⁻, [RSO₃]⁻. |
| | 1,1,3,3-tetramethylgyuanidrium | [TMGH]⁺ | For ammonium and sulfonium |
| | phosphazene bases | [PzH]⁺ | see previous tables. |
| | tris(dimethylamino)sulfonium | [3DMAmSulfH]⁺ | |
| | cyclopropenium | [Cp]⁺ | |

### Poly ILs.

A polyionic liquid or polymeric ionic liquid (PIL), is a type of ionic liquid where the ionic liquid moieties are incorporated into a polymer backbone. This results in a material that combines the unique properties of ionic liquids (such as high ionic conductivity, low volatility, and thermal stability) with the mechanical properties of polymers (such as flexibility, processability, and structural integrity). In a PIL the cation attaches to a backbone by containing a functional group compatible with or identical to functional groups and monomers present in the polymeric backbone. These polymers may comprise longer chains or smaller snippets providing mechanical rigidity to the ionic liquid cation without interfering with its ability to exchange charge and enhance film conductivity.

Examples of polymers used to form Poly ILs include the following:
poly(vinyl chloride) (PVC)
poly(ethylene oxide) (PEO)
poly(methyl methacrylate) (PMMA)
polystyrene (PS)
poly(acrylonitrile) (PAN)
poly(ethylene glycol) (PEG)
poly(dimethylsiloxane) (PDMS)
Poly(vinyl alcohol) (PVA)

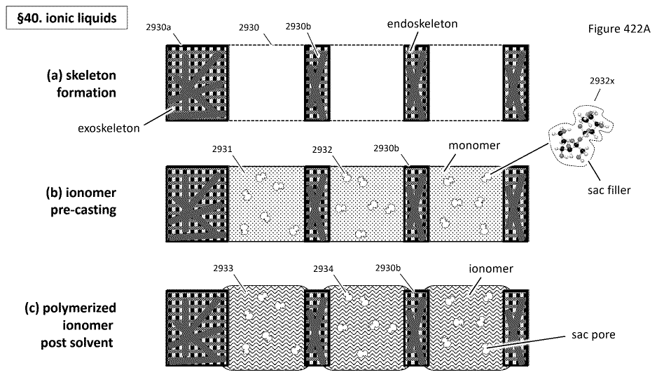

For example, IL cations containing a vinyl group will more easily bond with poly vinyl groups because of a shared chemical radicals and compatible charge structure. As a case in point, FIG. 421 illustrates the chemo-structural diversity of poly IL cations comprising vinyl cyclic compounds. These cations comprise a single pentagonal or hexagonal cyclic ring with one vinyl group comprising a —CH═CH₂ bond and another sidechain which may contain alkyl or phenyl groups. In poly(1-butyl-2-(3-vinylimidazolium) or [poly(BuVIm)]⁺ 2920, the cation includes imidazolium, a five-sided cyclic ring with two nitrogen substitutions and two side groups—one attached to a vinyl group ‘V’ and the second attached to a n=4 butyl (Bu) group. In poly(1-butyl-1-vinylpyrrolidinium) 2921, the vinyl and butyl group attach to a common nitrogen group. In poly(1-butyl-1-vinylpiperidinium) 2922 the two groups also attach to a common nitrogen anchor except that the five sided imidazolium cyclic ring is replaced by the hexagonal moiety piperidinium. The following table lists various PIL examples:

| Category | IL Cation Chemical Compound | Cation Symbol | Exemplary Anions |
|---|---|---|---|
| Poly(IL)s | poly(1-butyl-3-vinylimidazolium) | [Poly(BuVlm)]⁺ | [BF₄]⁻, [PF₆]⁻, [PF₆]⁻, |
| | poly(1-ethyl-3-vinylimidazolium) | [Poly(EtVlm)]⁺ | [CF₃SO₃]⁻, [Tf₂N]⁻, |
| | poly(1-hexyl-3-vinylimidazolium) | [Poly(H(CH₂)₆Vlm)]⁺ | [N(CN)₂]⁻, [Br]⁻, |
| | poly(1-octyl-3-vinylimidazolium) | [Poly(H(CH₂)₈Vlm)]⁺ | [CH₃COO]⁻, [I]⁻, |
| | poly(1-butyl-1-vinylpyrrolidinium) | [Poly(BuVPyrr)]⁺ | [CH₃SO₃]⁻, [IO₄]⁻, |
| | poly(1-ethyl-1-vinylpyrrolidinium) | [Poly[EtVPyrr]⁺ | [EtSO₄]⁻, [NO₃]⁻, |
| | poly(1-butyl-1-vinylpiperidinium) | [Poly[BuVPip]⁺ | [p-CH₃C₆H₄SO₃]⁻, |
| | poly(1-ethyl-1-vinylpiperidinium) | [Poly(EtVPip)]⁺ | [CH₃SO₃]⁻, [H₂PO₄]⁻, |
| | | | [HPO₄]²⁻, [HCOO]⁻, |
| | | | [C₆H₅COO]⁻, [ClO₄]⁻, |
| | | | [FSO₂NSO₂F]⁻, |
| | | | [C₂O₄]²⁻, [C₄H₄O₆]²⁻, |
| | | | [C₆H₅O₇]³⁻, [BO₃]³⁻, |
| | | | [CrO₄]²⁻, [Cr₂O₇]²⁻, |
| | | | [MnO₄]⁻,[SCN]⁻, |
| | | | [S₂O₃]²⁻, [IO₃]⁻, |
| | | | [Cl]⁻, [BF₄]⁻, [BH₄]⁻ |

Problems with ILs.

Despite their potential to improve the conductance properties of a ion exchange membrane ionic liquids suffer from a variety of issues. Among these the biggest issues are leakage and leaching of the IL escaping from the membrane, i.e. poor containment. The impact of IL leakage cause a number of significant issues.

For example, if the level of conductivity of an ion exchange membrane depends on charge transport enhancement from IL cations, any leakage or dispersion of the IL concentration over time will produce a marked decline in ionomer current and corresponding increase in membrane resistance and power loss. Higher power losses will also cause increased heating which may further accelerate the IL dispersion and leaching. In applications involving ionic filtering, any decline in IL content may compromise a separation membrane's ability to selectively remove impurities and contaminants.

Changes in IL concentration impacting the stoichiometry and charge balance in an ionomeric film can also adversely impact film stability, causing physical and chemical degradation of the membrane material, thereby reducing its lifespan and effectiveness. Changes in the membrane's internal environment due to IL loss can also cause IEM swelling or shrinkage, which can further compromise film integrity and performance.

Other considerations involve environmental impact including toxicity and persistence. Specifically many ILs are toxic to aquatic and terrestrial life where a release into the environment could cause significant ecological damage. ILs are often designed to be stable and non-volatile, persisting in the environment for long periods leading to long-term contamination with unknown toxic and mutagenic risks. Leakage could impact the health of both users and workers involved in fuel cell fabrication, requiring special handling, safety measures, and recycling protocols.

Another issue for ionic doping is membrane porosity. In polymeric ionomers, the crystallinity and atomic density of the film can range from dense matrices with limited sized pores and few channels to extremely porous films with extensive leakage aggravated by fuel crossover.

### Improved IL Doping.

To resolve problematic issues with ionic liquids, the methods used to form ionomeric polymers made in accordance with this invention stabilize the presence of ionic liquids within the ionomer. Once fabricated, the improved membrane thereby prevents leakage and seepage of ionic liquid thereby overcoming the deficiencies of conventional membranes.

The improved IL doping of an ion exchange membrane is achieved using fabrication of the inventive membrane described previously except that after molding the membrane is doped by ionic liquid doping then sealed by a coating. The features include:
a grid-like inert skeletal support for the membrane comprising an endoskeleton and exoskeleton;
micropores fabricated in the ionomer using a sacrificial filler during molding subsequently removed prior to ionic liquid doping;
sealing the ionic liquid into the membrane with the anode and cathode catalyst layers comprising a composition able to conducting electricity and transport gasses but relatively impervious to ionic liquids.

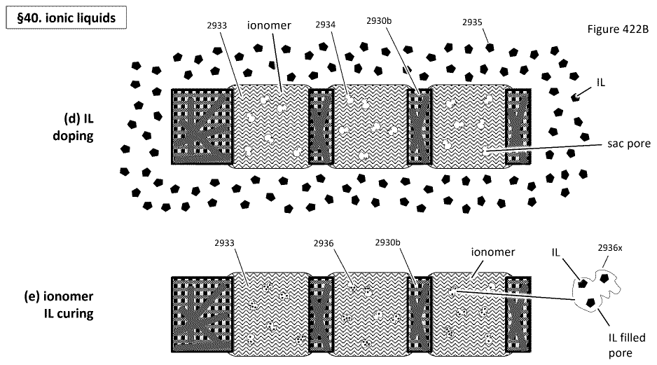

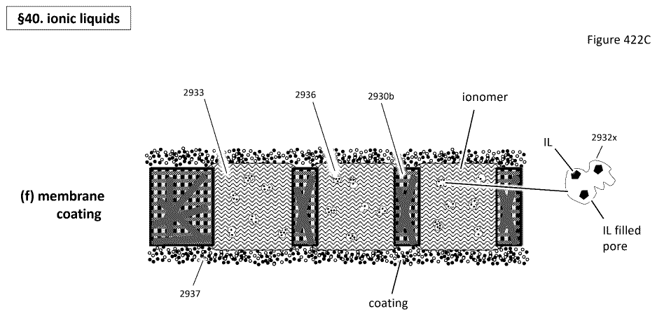

The fabrication sequence is illustrated in FIG. 422A where in step (a) a chemically inert skeleton 2930 is first fabricated using a polymer such as PTFE or a hydrocarbon based plastic optionally filled with mechanical supporting carbon fiber. The grid like structure may include wider exoskeletal pillars 2930a for laser cutting and narrower endoskeletal pillars for internal support. In step (b) a cast mold is loaded with skeletal grid and a mold compound comprising the ionomeric monomer or polymer powder 2931 and a sacrificial filler 2932 shown in detail as 1932x comprising a sugar or other material which can survive the molding process but subsequently be removed by a solvent such as water than will not damage the ionomeric polymer. In step (c) the mold compound of powder 2831 is polymerized into ionomer 2933 and the sacrificial filler removed using a solvent wash leaving empty sac pores 2834 in the matrix.

In step (d) shown in FIG. 422B, the membrane is coated or soaked in an ionic liquid 2935 whereby the IL penetrates the microporous matrix filling the empty pores 2934 with IL molecules forming pools of ionic liquids in sac pores 2936 as depicted in close up image 2936x shown in step (e). Finally in step (f) shown in FIG. 422C the membrane is coated by catalyst layers 2937 on both anode and cathode surfaces which in addition to catalyst metals and carbon may include a material relatively impervious to ionic liquid.

Made in accordance with this invention, the sealant additives included in modified catalyst layer 2937 may comprise any of the following:
carbon nanotubes (CNTs)—Carbon nanotubes can enhance electrical membrane conductivity and provide a barrier to ionic liquid leakage due to their high aspect ratio and surface area;
graphene oxide (GO)—GO can improve mechanical strength and provide a barrier to prevent ionic liquid leakage while maintaining good electrical conductivity;
silica (SiO₂) nanoparticles—Silica nanoparticles can be used to create a more tortuous path for the ionic liquid, reducing leakage while still allowing gas diffusion and maintaining conductivity;
zirconium phosphate (ZrP)—ZrP has been shown to improve proton conductivity and can help in creating a barrier to ionic liquid leakage;
metal-organic frameworks (MOFs)—MOFs can be tailored to have high surface area and porosity, which can help in gas diffusion and ionic liquid retention;
polymer binders: Polymers like Nafion® or other perfluorosulfonic acid (PFSA) ionomers can be used to enhance proton conductivity and provide a matrix that can help retain the ionic liquid within the membrane;
ceramic particles—Incorporating ceramic particles such as titania (TiO₂) or alumina (Al₂O₃) can improve the mechanical stability of the membrane and reduce ionic liquid leakage;
ionic liquid-immobilized (ILI NP) nanoparticles—Nanoparticles that are functionalized to immobilize ionic liquids can be used to retain the ionic liquid within the membrane while allowing gas and proton transport;
layered double hydroxides (LDHs)—LDHs can be used to enhance proton conductivity and provide a barrier to ionic liquid leakage due to their layered structure;
conductive polymers—Polymers such as polyaniline (PANI) or polypyrrole (PPy) can be used to enhance electrical conductivity and provide a barrier to ionic liquid leakage'
hybrid materials—Combining different materials, such as mixing carbon-based materials with inorganic nanoparticles, can create composite membranes with enhanced properties tailored for specific applications.
zeolites metal-organic framework (ZL-MOFs) Composites—These porous materials can be incorporated into the membrane to enhance gas permeability and selectively allow certain molecules to pass through while retaining ionic liquids.
cross-linked networks (XLN)—Creating a cross-linked polymer network as a catalyst coating can help in retaining the ionic liquid within the membrane, providing mechanical stability and reducing leakage.
nanofibers (NF) and electrospun membranes—Electrospinning techniques can produce nanofiber membranes with high surface area and porosity, which can be beneficial for retaining ionic liquids and enhancing gas transport.
functionalized silica nanoparticles (fSi-NP)—Silica nanoparticles functionalized with ionic liquid-compatible groups can improve the interaction between the ionic liquid and the membrane matrix, reducing leakage.
boron nitride (BN) Nanoparticles—BN nanoparticles can suppress IL leakage while also forming a barrier to carbon monoxide contamination causing catalyst poisoning;
self-healing materials—Incorporating self-healing polymers can help in maintaining membrane integrity and preventing ionic liquid leakage overtime.
layer-by-layer (LbL) Assembly—This technique allows for the precise control over the composition and thickness of each layer, which can be used to create a membrane with tailored properties for specific applications. LbL assembly may include sequenced deposition using sputtering, co-sputtering, multi-target sputtering, or molecular beam epitaxy.

The aforementioned processes of forming micropores using a sacrificial filler and then filling the pores with an ionic liquid may be used without employing a inert skeletal matrix of may be used in conjunction with the matrix. Similarly, the inert skeleton may be used to constrain the seepage and leakage of ionic liquids laterally throughout the film and along its periphery without employing the sacrificial filler method of pore formation.

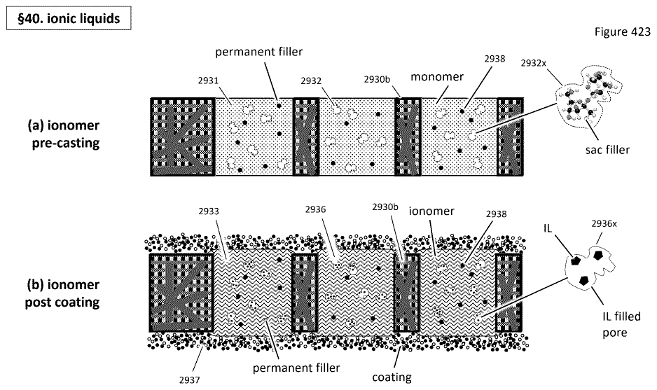

Another possibility is to combine the forgoing IL doping method with permanent fillers used to further enhance membrane conductivity. Unlike ILs which may be somewhat mobile within the membrane, permanent fillers made in accordance with this invention are bound to the matrix in fixed location. In fabrication, the permanent filler is added to the mold compound prior to polymerization. As shown in step (a) of FIG. 423, the mold compound 2931 is mixed in powder form or in solution with ionomer monomer 2931 and with permanent filler 2938 then molded. After polymerization and removal of the sac filler, the ionomer 2933 is polymerized leaving pores 2936 subsequently filled with ILs as shown by close up 2936x along with permanent fillers 2938. In this manner both the IL and permanent fillers contribute to ionomers performance by enhancing conductivity while the endoskeleton and permanent filler enhance structural support.

Permanent fillers as described herein include graphene oxides (GOs) including perfluoropolyether grafted graphene oxide (PFPE-GO) or poly (2,5-benzimidazole) grafted graphene oxide (ABPBI-GO); phosphotungstic acid (PWA) crystallites; bismuth trimesic acid (BiTMA); bismuth molybdate (Bi₂MoO₆); bismuth metal oxide frameworks (BiMOF); sulfonated poly ether sulfone conjugates (SPESf) with BiTMA, Bi₂MoO₆ or BiMOF; neutral carbon walled nanotubes (CNTs); single or multiwalled carbon nanotubes functionalized by SO₃H, COOH, POH, —NH₂, SiO₂, chitosan (CS), or TiO₂; carbon nanoflakes; mesostructured cellular foam (silica MCF); nesosilicates ((SiO₄)⁴⁻). Another chitosan carbon nanotube is comprises the graft chitosan-g-styrenesulfonic acid (CS-g-SSA CNT). Chitosan also may bond to sulfonated graphene oxide (CS-sGO).

Other permanent dopants include phosphorylated hollow mesoporous silica with phosphoric acid (HMS-PA); nascent mesostructured cellular foam (MCF); sulfonated mesostructured cellular foam (MCF-SO₃H); hydroxy mesostructured cellular foam (MCF-OH); amino mesostructured cellular foam (MCF-NH₂); aluminum-grafted mesoporous silica (AI-MCF); aluminum-grafted hybrid mesoporous silica (mPBI-AI-MCF); covalent triazine framework (C₃H₃N₃); poly(methyl methacrylate) nanospheres (PMMA-NS); Pd-poly(methyl methacrylate) nanoclusters (Pd-PMMA NCs); sulfonated poly(methyl methacrylate) nanospheres (sPMMA NS); nascent porous poly(methyl methacrylate) nanospheres (PMMA NS); poly methyl methacrylate sulfonated zinc nanospheres and nanoclusters (PMMA ZnS NS/NC); and poly methyl methacrylate zinc oxide nanospheres (PMMA ZnO NS/NC).

Another class of permanent dopants include polyhedral oligomeric silsesquioxanes (POSS) including thiol (POSS-SH), phosphoric (POSS-PA), isobutyl (POSS-iBu), vinyl (POSS-Vi), 1-chlorobutane (POSS-BCl), octakis(dimethylsilyloxy) (Ot-POSS), octavinyl (OV-POSS), octaphenyl (OPh-POSS), isobutyl-vinyl (POSS-iBu-Vi), isobutyl-butylamine (POSS-iBu-NH₂), butyl chloride (POSS-BuCl), isobutyl hydroxide (POSS-iBu-OH), isobutyl-styryl (POSS-iBu-styryl), isobutyl-polystyrene (POSS-iBu-PS), cyclopentyl-polystyrene (POSS-Cp-PS), cyclohexyl-polystyrene (POSS-Cy-PS), aminopropylisobutyl (POSS-AM-iBu), mercaptopropyl-isobutyl (POSS-SJ-iBu), and other generic variants such as mono(acryloisobutyl) (POSS-A). Sulfonated polyhedral oligomeric silsesquioxanes (sPOSS) include cyclopentyl-polystyrene (sPOSS-Cp-PS) and cyclohexyl-polystyrene (POSS-Cy-PS). Related moieties and isomers include double decker silsesquioxane (DDSQ) including methylated and non-methylated functionalized variants (Me DDSQ-R) and (NMe DDSQ-R) where R may comprise vinyl, methylpropyl, methyltrichlorosilane, dichloromethylvinylsilane, stereo-vinyl, allyloxytrimethylsilane, amino-butyloxycarbonyl, propyl glycidyl ether radicals, 4-bromostyrene, 4-acetoxystyrene, or trioxy-indole radicals.

Other permanent dopants include various nanocomposites including zirconium composite membrane (ZVM, ZrCM) and platinum composite membranes (PtCM), nanoparticle coated carbon nanotubes (NP CNT) functionalized by amino (NH₂), platinum-amino (Pt—NH₂), titanium-amino groups (Ti—NH₂), and platinum-tin (Pt—Sn) adsorbed surface groups. Platinum titanium dioxide nanoparticles (Pt—TiO₂ NP) together with graphene oxide sulfone (FPGO-sPSf) also can enhance film conductivity and stability.

Other nanostructure permanent dopants include electrospun nanofibers (NF) such as poly sulfonated polystyrene nanofibers (P(sPS)NF). Other dopants include poly dopamine and poly sulfonated dopamine P(DA-sDA), silver nanoparticles (Ag-NP), cobalt nanoparticles (Co-NP) and ionomeric nanoparticles (PFSA-PTFE NP). Zirconium dopants include intercalant Zr of types α, γ, and λ; and zirconium nanospheres.

A large class of permanent dopants that may be mixed with ionic liquids include metal oxide frameworks (MOFs) including zirconium, tungsten, iron, zinc, zinc-oxide, chromium, along with catalyst and scavenger metals. MOF dopants may also include triazole or phosphoric acid guests and grafts. A specialized category of MOFs comprises structural forms of tungsten including tungsten-carbon nanoparticles (WC NP) and phosphotungstic acid (PWA). Other fillers include the aluminum silicon composite ‘zeolite’ which may be functionalized by acids such as phenylsulfuric acid (PhSA-ZI) or sulfonic acid (HSO₃S) in sulfonated mordenite. Zeolite may be formed into nanocrystals functionalized by acids or metals.

For higher temperature applications, p-oxydiphenylene-benzimidazole (OPBI) may form stable nanostructure copolymer dopants with hexachlorocyclotriphosphazene (HCCP-co-PBI); with imidazolechlorocyclotriphosphazene (ImCCP-co-PBI); and with zeolitic imidazolate frameworks (PBI-co-ZIF).

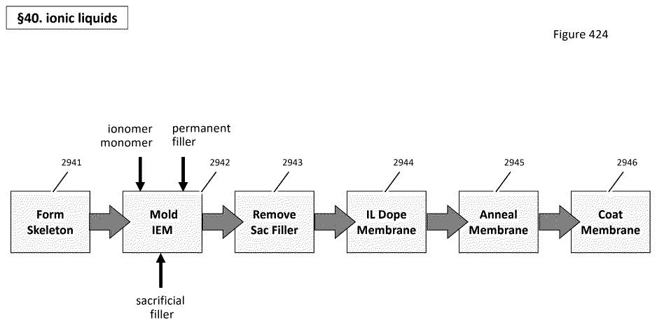

The corresponding flow chart for including ionic liquids into the aforementioned membranes made in accordance with this invention is illustrated in FIG. 424 where an IL doped ion exchange membrane (IL IEM) starts with the formation of the exoskeletal-endoskeletal framework in step 2941 entitled “Form Skelton.” The formation of a grid-like network of carbon- or plastic-reinforced pillars is described in detail previously in this application and will not be repeated here.

In step 2942 “Mold IEM” the ionomer monomer is mixed with solvent and cross linkers together with sacrificial filler and any permanent fillers, then polymerized at the applicable temperature. In step 2943 “Remove Sac Filler,” a solvent such as water is used to dissolve and remove the sacrificial filler from the membrane. The solvent has no significant effect on the membrane polymer, the skeletal pillars, or any permanent fillers and dopants. In step “IL Dope Membrane” the membrane is coated or immersed in ionic liquid and soaked until the IL penetrates into the pores in the ionomer's polymer matrix including accumulating in the previously formed sac pores.

The membrane is then thermally annealed in step 2945 “Anneal Membrane” to remove any excess solvent or water. Finally the exterior surface of the IEM is coated on both the anode and cathode sides in step 2946 “Coat Membrane.” The coating may be combined with the catalyst layer slurry including catalyst metal, carbon, and any other barrier materials like boron nitride. In addition to functioning as the catalyst layer of the CCM the coating also serves as the sealant to prevent ionic liquid leakage from the membrane's surfaces. Alternatively the sealant may be deposited in a separate step from the catalyst layer after or more likely before the CL formation. The sealant layer maybe formed using immersion is a solution, by spray coating, printing, or by sputtering.

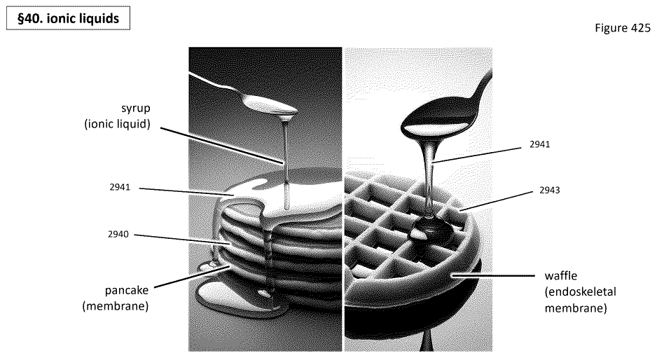

While this coating prevents IL leakage from the planar surfaces of the membrane is doesn't stop leakage of the ionic liquid laterally out of the sides of the membrane. The chemically inert skeletal structure is however impervious to IL diffusion. Together with the sealant the IL is confined into a cube or rectangular enclosure bounded on all side. An AI generated depiction of endoskeletal confinement of ionic liquid in and atop a membrane is depicted metaphorically as syrup and pancakes and waffles as shown in FIG. 425. Using syrup 2941 to represent the viscous yet fluid ionic liquid, soaking a membrane lacking any skeletal structure in the IL as illustrated by pancake 2940 means the IL is free to move laterally along or with the membrane eventually running off or out of the edges. By contrast, the skeletal membrane depicted by waffle 2943 prevents the IL from escaping its confinement and leaking from the membrane.

### IL Membrane Compatibility.

The compatibility of a specific ionic liquid and particular composition of IEM depends on the ability of the ionomer to cooperatively conduct ions through a Grotthuss hopping conduction mechanism and through vehicular transport, generally involving the drift and diffusion of hydronium cations. Other considerations involve the mutual compatibility of the IL and IEM operating together over a specific temperature range, the pH of the ionic liquid, and any damage the IL might cause the ionomer or its polymeric backbone.

In general, ionic liquids containing halides, high viscosity, poor thermal stability, and long alkyl chains are generally not suitable for use in proton exchange membranes due to their potential to cause phase separation, reduce ionic conductivity, and degrade membrane material. Factors include poor membrane stability in the presence of strong acids aggravated by the IL; poor thermal stability over expected operating temperature ranges possibly causing the IL to decompose; high reactivity causing IL conductivity to degrade through unwanted chemical reactions thereby impeding its ability to absorb and donate protons into solution; and the inability of an IL to form a uniform, stable phase with the membrane material.

In ionomers relying on high levels of hydration and water-borne charge transport, ion liquids with excessive hydrophobicity may be unable to engage in charge transfer with membrane attached ionomer groups. For optimal benefit in cation conduction, it is therefore important to pair ionic liquids with a ion exchange membrane material to ensure compatible and durability, offer efficient ion transport, and deliver stable operation. For operation below 100° C., this criteria also means the ionic liquid should exhibit low viscosity at its nominal operating temperature.

The following table describes the best and worst combinations of PEM membranes with various ionic liquids:

| § | PEM Structure | Beneficial(Best)ILs | Unsuitable(Worst)ILs |
|---|---|---|---|
| 1 | PFSA | [EtMelm]⁺ [OTf]⁻, [EtMelm]⁺ [Tf₂N]⁻, | [EtMelm]]⁺[Cl]⁻, |
| | homopolymer | [EtMelm]⁺[TFSIm]⁻, [EtMelm]⁺ [MeSO₃]⁻, | [BuMelm]⁺[Cl]⁻, |
| | (PFSA) | [BuMelm]⁺ [OTf]⁻, [HexMelm]⁺[Tf₂N]⁻, | [EtMelm]⁺[BF₄]⁻, |
| | | [EtPyr]⁺ [OTf]⁻, [BuPyr]⁺[BF₄]⁻, | [BuMelm]⁺[BF₄]⁻, |
| | | [P6,6,6,14]⁺[Tf₂N]⁻ | [EtMelm]⁺[PF₆]⁻ |
| | | | [BuMelm]⁺[PF₆]⁻, |
| | | | [EtMelm]⁺[DCA]⁻, |
| | | | [BuMelm]⁺[DCA]⁻, |
| | | | [EtMelm]⁺[SCN]⁻, |
| | | | [BuMelm]⁺[SCN]⁻ |
| 2 | PFSA CRM | [BuMelm]⁺[PF₆]⁻, [HexMelm]⁺[Tf₂N]⁻, | [BuMelm]⁺[Cl]⁻; |
| | heteropolymer | [OctMelm]⁺[BF₄]⁻, [EtMelm]⁺[Tf₂N]⁻, | [OctMelm]⁺[Cl]⁻; |
| | (PFSA-PTFE) | [DecMelm]⁺[Cl]⁻, [BuMelm]⁺[OTf]⁻, | [EtMelm]⁺[Br]⁻; |
| | | [HexMelm]⁺[PF₆]⁻, [BuMePyrr] ⁺[Tf₂N]⁻, | [HexMelm]⁺[PF₆]⁻; |
| | | [BuMelm]⁺[DCA]⁻, [EtMelm]⁺[OAc]⁻, | [BuMelm]⁺[HSO₄]⁻; |
| | | [BuMelm]⁺[BF₄]⁻ | [BuMelm]⁺[SCN]⁻; |
| | | | [BuMelm]⁺[OAc]⁻; |
| | | | [BuMelm]⁺[BF₄]⁻; |
| | | | [BuMelm]⁺[DCA]⁻; |
| | | | [EtMelm]⁺[EtSO₄]⁻ |
| 3 | amorphous glassy | [EtMelm]⁺[TfO]⁻, BuMelm]⁺[PF₆]⁻, | [BuMelm]⁺[Cl]⁻, |
| | matrices | [EtMelm]⁺[NTf₂]⁻, [BuMelm]⁺[TfO]⁻, | [EtMelm]⁺[OAc]⁻, |
| | (PDD, PFMMD) | [BuMelm]⁺ [BF₄]⁻, [HexMelm]⁺[NTf₂]⁻, | [BuMelm]⁺[NO₃]⁻, |
| | | [BuMelm]⁺[DCA]⁻, [BuMePyrr]⁺[TFSI]⁻, | [BuMelm]⁺[SCN]⁻, |
| | | [EtMePyrr]⁺[FSI]⁻, [BuMePip]⁺[TFSI]⁻, | [BuMelm]⁺[H₂PO₄]⁻, |
| | | [EtMePip]⁺[FSI]⁻, [P6,6,6,14]⁺[TFSI^{]-}, | [EtMelm]⁺[HSO₄]⁻, |
| | | [P6,6,6,14]⁺[DCA]⁻, [MePyr]⁺[BF₄]⁻ | [BuMelm]⁺[HCOO]⁻, |
| | | [(DEt)(MeOEt)Am]⁺[TFSI]⁻, | [EtMelm]⁺[OTf]⁻, |
| | | [TEtAm]⁺[TFSI]⁻, [TEtS]⁺[TFSI]⁻, | [BuMelm]⁺[Cl]⁻, |
| | | [TMeS]⁺[FSI]⁻, [BuPyr]⁺[TFSI]⁻, | [BuMelm]⁺[Br]⁻ |
| 4 | polyethylene | [EtMelm]⁺[BF₄]⁻, [BuMelm]⁺[BF₄]⁻, | [BuMelm]⁺[Cl]⁻, |
| | (PE) | [EtMelm]⁺[NTf₂]⁻, [BuMelm]⁺[NTf₂]⁻, | [EtMelm]⁺[OAc]⁻, |
| | | [EtMelm]⁺[DCA]⁻, [BuMelm]⁺[DCA]⁻, | [BuMelm]⁺[BF₄]⁻, |
| | | [BuMelm]⁺[PF₆]⁻, [EtMelm]⁺[BF₄]⁻, | [HexMelm]⁺[PF₆]⁻, |
| | | [EtMelm]⁺[OAc]⁻, [BuMelm]⁺[Cl]⁻ | [OctMelm]⁺[Tf₂N]⁻, |
| | | | [BuMelm]⁺[DCA]⁻ |
| 5 | polyvinyl alcohol | [BuMelm]⁺[Cl]⁻, [EtMelm]⁺[OAc]⁻, | [BuMelm]⁺[Cl]⁻, |
| | (PVA) | [HexMelm]⁺[PF₆]⁻, [BuMelm]⁺[BF₄]⁻, | [HexMelm]⁺[Cl]⁻, |
| | | [EtMelm]⁺[OTf]⁻, [BuMePyrr]⁺[NTf₂]⁻, | EtMelm]⁺[OTf]⁻, |
| | | [TBuAm]⁺[Br]⁻, [TBuP]⁺[Cl]⁻, | [BuMelm]⁺[OTf]⁻, |
| | | [DEt(MeEt)Am]⁺[NTf₂]⁻, [TEtS]⁺[NTf₂]⁻, | [EtMelm]⁺[OAc]⁻, |
| | | [BuMePyrr]⁺[DCA]⁻, [Choline]⁺[DHP]⁻ | [BuMelm]⁺[OAc]⁻, |
| | | | [BuMelm]⁺[BF₄]⁻ |
| 6 | polyvinyl difluoride | [BuMelm]⁺[BF₄]⁻, [EtMelm]⁺[OTf]⁻, | [BuMelm]⁺[Cl]⁻, |
| | (PVDF) | [HexMelm]⁺[PF₆]⁻, [TBuAm]⁺[BF₄]⁻, | [EtMelm]⁺[OAc]⁻, |
| | | [TEtS]⁺[TFSI]⁻, [MePrPyrr]⁺[TFSI]⁻ | [HexMelm]⁺[Cl]⁻, |
| | | | [TBuP]⁺[Cl]⁻, |
| | | | [MePrPyrr]⁺[Cl]⁻ |
| 8 | polyvinyl chloride | [BuMelm]⁺[BF₄]⁻, [EtMelm]⁺[Tf₂N]⁻, | [BuMelm]⁺[Cl]⁻, |
| | (PVC) | [HexMelm]⁺[PF₆]⁻, [TEtAm]⁺[BF₄]⁻, | [HexMelm]⁺[Cl]⁻, |
| | | [MePyr]⁺[BF₄]⁻, [Cho]⁺[DHP]⁻ | [MePrPip]⁺[Cl]⁻, |
| | | | [EtMelm]⁺[OAc]⁻ |
| 9 | polyimide | [BuMelm]⁺[Tf₂N]⁻, [EtMelm]⁺[BF₄]⁻, | [BuMelm]⁺[Cl]⁻, |
| | (PI) | [HexMelm]⁺[Tf₂N]⁻, [Bu₄P]⁺[Tf₂N]⁻, | [HexMelm]⁺[Cl]⁻, |
| | | [MePrPyrr]⁺[Tf₂N]⁻, [Bu₄N]⁺[Tf₂N]⁻ | [MePrPip]⁺[Cl]⁻, |
| | | | [EtMelm]⁺[OAc] |
| 10 | polystyrene | [BuMelm]⁺[BF₄]⁻, [EtMelm]⁺[Tf₂N]⁻, | [BuMelm]⁺[Cl]⁻, |
| | (PS) | [HexMelm]⁺[PF₆]⁻, [TEtAm]⁺[BF₄]⁻, | [HexMelm]⁺[Cl]⁻, |
| | | [MePyr]⁺[BF₄]⁻, [Cho]⁺[DHP]⁻ | [MePrPip]⁺[Cl]⁻, |
| | | | [EtMelm]⁺[OAc]⁻ |
| 11 | poly fluorenyl ether | [EtMelm]⁺[TfO]⁻, [BuMelm]⁺ [BF₄]⁻, | [BuEtlm]⁺[Cl]⁻, |
| | ketone nitrile | [HexMelm]⁺[NTf₂]⁻, [TEtAm]⁺[NTf₂]⁻, | [BuMelm]⁺[Cl]⁻, |
| | (PFEKN) | [Et₃S]⁺[TfO]⁻, [MePrPyrr]⁺[NTf₂]⁻ | [EtMelm]⁺[OAc]⁻, |
| | | | [BuMelm]⁺[DCA]⁻, |
| | | | [TBuAm]⁺[I]− |
| 12 | polyphenylene | [BuMelm]⁺[BF₄]⁻, [HexMelm]⁺[NTf₂]⁻, | [BuMelm]⁺[Cl]⁻, |
| | (PPh) | [(H(CH₂)ₙ)₄N]⁺[NTf₂]⁻, [(H(CH₂)ₙ)Pyr]⁺[NTf₂]⁻, | [EtMelm]⁺[Ac]⁻, |
| | | [(H(CH₂)ₙ)₄P]⁺[NTf₂]⁻ | [BuMelm]⁺[OH]⁻, |
| | | | [N2222]⁺[Cl]⁻, |
| | | | [MePyr]⁺[Cl]⁻ |
| 13 | polyarylene ether | [EtMelm]⁺[TfO]⁻, [BuMelm]⁺ [BF₄]⁻, | [BuEtlm]⁺[Cl]⁻, |
| | (PAE) | [HexMelm]⁺[NTf₂]⁻, [TEtAm]⁺[NTf₂]⁻, | [BuMelm]⁺[Cl]⁻, |
| | | [Et₃S]⁺[TfO]⁻, [MePrPyrr]⁺[NTf₂] | [EtMelm]⁺[OAc]⁻, |
| | | | [BuMelm]⁺[DCA]⁻, |
| | | | [TBuAm]⁺[I]− |
| 14 | poly ether ketones | [EtMelm]⁺[TfO]⁻, [BuMelm]⁺ [BF₄]⁻, | [BuEtlm]⁺[Cl]⁻, |
| | (PEK, PEEK, PEₓK_{y}) | [HexMelm]⁺[NTf₂]⁻, [TEtAm]⁺[NTf₂]⁻, | [BuMelm]⁺[Cl]⁻, |
| | | [Et₃S]⁺[TfO]⁻, [MePrPyrr]⁺[NTf₂]⁻ | [EtMelm]⁺[OAc]⁻, |
| | | | [BuMelm]⁺[DCA]⁻, |
| | | | [TBuAm]⁺[I]− |
| 15 | poly ether sulfones + | [EtMelm]⁺[TfO]⁻, [BuMelm]⁺ [BF₄]⁻, | [BuEtlm]⁺[Cl]⁻, |
| | ketones | [HexMelm]⁺[NTf₂]⁻, [TEtAm]⁺[NTf₂]⁻, | [BuMelm]⁺[Cl]⁻, |
| | (PESf, PEKSf) | [Et₃S]⁺[TfO]⁻, [MePrPyrr]⁺[NTf₂]⁻ | [EtMelm]⁺[OAc]⁻, |
| | | | [BuMelm]⁺[DCA]⁻, |
| | | | [TBuAm]⁺[I]− |
| 37 | polysulfone acid-base | [BuMelm]⁺[BF₄]⁻, [EtMelm]⁺[Tf₂N]⁻, | [BuMelm]⁺[Cl]⁻, |
| | polymer | [HexMelm][PF₆]⁻, [Et₄N]⁺[BF₄]⁻, | [MeOctlm]⁺[Cl]⁻, |
| | (PSf) | [Ch]⁺[Tf₂N]⁻, [EtPyr]⁺[Tf₂N]⁻ | [Et₃NH]⁺[OAc]⁻, |
| | | | [HexMelm]⁺[Br]⁻, |
| | | | [BuMelm]⁺[DCA]⁻ |
| 38 | anhydrous phenylene- | [EtMelm]⁺[OTf]⁻, [BuMelm]⁺[BF₄]⁻, | [BuMelm]⁺[Cl]⁻, |
| | bibenzimidazole | [EtMelm]⁺[Tf₂N]⁻, BuMePyrr]⁺[Tf₂N^{]-}, | [EtMelm]⁺[Cl]⁻, |
| | (PBI) | [MePrPyrr]⁺[Tf₂N]⁻, [NBu₄]⁺[Tf₂N]⁻, | [BuMelm]⁺[Br]⁻, |
| | | [BuMePip]⁺[Tf₂N]⁻ | [HexMelm]⁺[Cl]⁻, |
| | | | [OctMelm]⁺[Cl]⁻, |
| 39 | chitosan & cellulose | [BuMelm]⁺[Cl]⁻, [EtMelm]⁺[OAc]⁻, | [BuMelm]⁺[PF₆]⁻, |
| | biopolymer | [HexMelm]⁺[BF₄]⁻, [TBuAm]⁺[Br]⁻, | [HexMelm]⁺[PF₆]⁻, |
| | (CS, CL) | [Ch]⁺[DHP]⁻, [Pyr]⁺[Cl]⁻ | [EtMelm]⁺[Tf₂]⁻, |
| | | | [BuMelm]⁺[DCA]⁻, |
| | | | [HexMelm]⁺[Tf₂N]⁻ |

### IL-Doped PFSA Homopolymer IEM:

The performance of proton exchange membranes (PEMs) in fuel cells described in § 1 is highly dependent on the properties of the ionic liquids (ILs) used. For a PEM comprising a perfluorosulfonic acid (PFSA) homopolymer, the IL stoichiometry of both the cation and anion significantly influences IEM conductivity, stability, and overall efficiency. Ionic liquids offering good compatibility with bulk PFSA ionomers include imidazolium, pyridinium, phosphonium, sulfonate, and protic ionic liquid (PIL) based cations. Imidazolium-based ionic liquids provide high thermal stability and good proton conductivity.

Examples include the ionic liquid 1-ethyl-3-methylimidazolium trifluoromethanesulfonate [EtMeIm]⁺[OTf]⁻; 1-ethyl-3-methylimidazolium bis(trifluoromethylsulfonyl)imide [EtMeIm]⁺[Tf₂N]⁻; bis(trifluoromethylsulfonyl)imide [EtMeIm]⁺[TFSIm]⁻. Other PFSA compatible [Im]⁺ based ionic liquids include 1-ethyl-3-methylimidazolium methanesulfonate [EtMeIm]⁺[MeSO₃]⁻; 1-butyl-3-methylimidazolium tetrafluoroborate [BuMeIm]⁺[BF₄]⁻; 1-butyl-3-methylimidazolium trifluoro-methanesulfonate [BuMetIm]⁺[OTf]⁻, and 1-hexyl-3-methylimidazolium bis(trifluoromethylsulfonyl) imide [HexMeIm]⁺[Tf₂N]⁻.

Pyridinium based ionic liquids compatible with bulk PFSA films include N-ethylpyridinium trifluoromethanesulfonate [EtPyr]⁺[OTf]⁻ and N-butylpyridinium tetrafluoroborate [BuPyr]⁺[BF₄]⁻. Applicable phosphonium-based ILs include trihexyl(tetradecyl)phosphonium bis(trifluoromethyl sulfonyl)imide with the chemical formulation [(H(H₂C)₆)₃(H(H₂C)₁₄)P]⁺[Tf₂N]⁻ abbreviated as [P6, 6, 6,14]⁺[Tf₂N]⁻.

Ionic liquids unsuitable for use in bulk PFSA homopolymer films include the [Im]⁺ based moieties 1-ethyl-3-methylimidazolium chloride [EtMeIm]]⁺[Cl]⁻ and 1-butyl-3-methylimidazolium chloride [BuMeIm]⁺[Cl]⁻ where the chlorine radical can damage the ionomer and degrade conductance. Some ILs may result in chemical instability in bulk PFSA. They include ethyl-3-methylimidazolium tetrafluoroborate [EtMeIm]⁺[BF₄]⁻ and 1-butyl-3-methylimidazolium tetra-fluoroborate [BuMeIm]⁺[BF₄]⁻. Both the [Im]⁺ based ionic liquids 1-ethyl-3-methylimidazolium hexafluorophosphate [EtMeIm]⁺[PF₆]⁻ and 1-butyl-3-methylimidazolium hexafluorophosphate [BuMeIm]⁺[PF₆]⁻ may cause membrane degradation through hydrolysis. Other chemically aggressive ILs include 1-ethyl-3-methylimidazolium dicyanamide ([EtMeIm]⁺[DCA]⁻, 1-butyl-3-methylimidazolium dicyanamide [BuMeIm]⁺[DCA]⁻, 1-ethyl-3-methylimidazolium thiocyanate [EtMeIm]⁺[SCN]⁻ and 1-butyl-3-methylimidazolium thiocyanate [BuMeIm]⁺[SCN]⁻ can also irrevocably deregulate a PFSA membrane.

### IL-Doped PFSA-PTFE CRM Heteropolymer IEMs.

Although a composite reinforced membrane (CRM) comprising perfluorinated sulfonic acid (PFSA) supported by a polytetrafluoroethylene (PTFE) backbone described in § 2 still contains perfluorinated sulfonic acid, the best suited ionic liquids for a PFSA-PTFE heteropolymer membrane differs from its homopolymer sibling primarily due to distinct structural and chemical properties of both membrane types. In a PFSA homopolymer is hydrophilic while CRM moieties contain both hydrophobic and hydrophilic groups. Specifically ILs must be compatible with both PFSA and PTFE and not degrade or adversely affect the mechanical properties of the PTFE support framework.

Moreover, to enhance the mechanical properties of PTFE in a CRM, an ionic liquid must contain at least in part hydrophobic functional groups. While IL hydrophobicity does not impede Grotthuss hopping conduction of sulfonic acid ionomers, such ILs offer no substantive benefit to pure PFSA homopolymers which contain minimal segments of hydrophobic blocks along its spine. Ionic liquids better suited for PFSA-PTFE CRMs comprise imidazolium cations with anions that do not degrade the membrane's hydrophobic polymeric backbone such as butyl-3-methylimidazolium hexafluorophosphate [BuMeIm]⁺[PF₆]⁻, offering good chemical stability and hydrophobic properties, which can interact favorably with PTFE. However, its hydrophobic nature is not beneficial for pure PFSA membranes, which require high proton conductivity.

Another CRM compatible ionic liquid includes 1-hexyl-3-methylimidazolium [HexMeIm]⁺[Tf₂N]⁻, whose hydrophobicity enhances the mechanical stability of PFSA-PTFE composites, but cannot enhance proton conductivity in pure PFSA membranes. The IL 1-octyl-3-methylimidazolium tetrafluoroborate [OctMeIm]⁺[BF₄]⁻ is hydrophobic and can improve the mechanical properties of PFSA-PTFE composites. Its lower affinity for water however renders it less suitable for pure PFSA membranes relying on water for proton conductivity.

Similarly, 1-ethyl-3-methylimidazolium bis(trifluoromethylsulfonyl)imide [EtMeIm]⁺[Tf₂N]⁻, provides good thermal and chemical stability, which complements the PTFE structure. Its low water uptake is however nor advantageous for PFSA homopolymer membranes. Another ionic liquid 1-decyl-3-methylimidazolium chloride [DecMeIm]⁺[Cl]⁻ the molecule's long alkyl chain increases hydrophobicity benefiting PFSA-PTFE composites. However, it does not support the high proton conductivity required in pure PFSA membranes. Likewise 1-butyl-3-methylimidazolium trifluoromethanesulfonate [BuMeIm]⁺[OTf]⁻ offers a balance between hydrophilicity and hydrophobicity, enhancing the mechanical and thermal stability of PFSA-PTFE composites. However, only moderate water uptake is not ideal for PFSA membranes that depend membrane hydration.

The ionic liquid 1-hexyl-3-methylimidazolium hexafluorophosphate [HexMeIm]⁺[PF₆]⁻ and similarly 1-ethyl-3-methylimidazolium acetate [EtMeIm]⁺[OAc]⁻ and 1-butyl-3-methylimidazolium tetrafluoroborate [BuMeIm]⁺[BF₄]⁻ are hydrophobic in nature with good thermal stability, and therefore better suited for PFSA-PTFE composites. Their hydrophobicity, however, limits the ILs' utility in homopolymer PFSA membranes. Another IL, 1-butyl-3-methylimidazolium dicyanamide [BuMeIm]⁺[DCA]⁻, enhance the mechanical properties of PFSA-PTFE composites but is also beneficial in maintaining a balance in proton conductivity for PFSA membranes. Aside from imidazolium cation, pyrrolidinium based ionic liquids such as 1-butyl-1-methylpyrrolidinium bis(trifluoro methylsulfonyl)imide [BuMePyrr]⁺Tf₂N]⁻ are also useful in enhancing film property.

Specifically ionic liquids that are not suitable for use in PFSA-PTFE heterogeneous membranes are those that comprise (a) excessively hydrophobic causing phase separation and loss of mechanical integrity in the membrane; (b) excessively viscous hindering ion transport and reducing membrane efficiency; (c) contain reactive groups such as halides (e.g., chloride, bromide) or strong acids/bases that can chemically degrade the PFSA or PTFE components; (d) aprotic ionic liquids can lead to dehydration of the membrane, reducing proton conductivity; (e) Ionic Liquids with high electronegativity which can extract water from the membrane, leading to dehydration and reducing performance; and (f) ILs with poor thermal stability.

Ionic liquids hostile to PFSA-PTFE CRMs include a variety of anions. For example, chloride [Cl]⁻ and bromine [Br]⁻ anions can be reactive and lead to chemical degradation of the membrane such as 1-butyl-3-methylimidazolium chloride [BuMeIm]⁺[Cl]⁻; 1-octyl-3-methylimidazolium chloride [OctMeIm]⁺[Cl]⁻; 1-ethyl-3-methylimidazolium bromide [EtMeIm]⁺[Br]⁻. Highly acidic ionic liquids or compounds that hydrolyze to form highly corrosive HF acid. Examples include 1-hexyl-3-methylimidazolium hexafluorophosphate [HexMeIm]⁺[PF₆]⁻; 1-butyl-3-methylimidazolium hydrogen sulfate [BuMeIm]⁺[HSO₄]⁻; and 1-butyl-3-methylimidazolium thiocyanate [BuMeIm]⁺ [SCN]⁻. Other ionic liquids which may become unstable and degrade the membrane's polymeric matrix include acetate [OAc]⁻, tetrafluoroborate [BF₄]⁻, dicyanamide [DCA]⁻, and ethylsulfate [EtSO₄]⁻ anions, with exemplary ILs comprising 1-butyl-3-methylimidazolium acetate [BuMeIm]⁺[OAc]⁻; 1-butyl-3-methylimidazolium tetrafluoroborate [BuMeIm]⁺[BF₄]⁻; 1-butyl-3-methyl imidazolium dicyanamide [BuMeIm]⁺[DCA]⁻; and 1-ethyl-3-methylimidazolium ethylsulfate [EtMeIm]⁺[EtSO₄]⁻.

### IL-Doped Glassy Matrix IEMs.

The compatibility of ionic liquids with proton exchange membranes (PEMs) comprising amorphous glassy matrices such as perfluorodioxole (PDD) and perfluoromethyl dioxole (PFMMD) described in § 3 can be influenced by various factors, including the ionic liquid's chemical structure, size, and interaction with the polymer matrix. Examples of ionic liquids compatible with glassy matrix membranes include those containing imidazolium cations such as 1-ethyl-3-methylimidazolium trifluoromethanesulfonate [EtMeIm]⁺[TfO]⁻; 1-butyl-3-methyl imidazolium hexafluorophosphate [BuMeIm]⁺[PF₆]⁻; 1-ethyl-3-methylimidazolium bis(trifluoro methylsulfonyl)imide [EtMeIm]⁺[NTf₂]⁻; and 1-butyl-3-methylimidazolium trifluoromethane sulfonate [BuMeIm]⁺[TfO]-offering good thermal stability and ionic conductivity. Other ILs include 1-butyl-3-methylimidazolium tetrafluoroborate [BuMeIm]⁺[BF₄]⁻ and 1-hexyl-3-methylimidazolium bis(trifluoromethylsulfonyl)imide [HexMeIm]⁺[NTf₂]⁻; along with 1-butyl-3-methyl imidazolium dicyanamide [BuMeIm]⁺[DCA]⁻ offering good compatibility with fluorinated matrices.

Aside from ILs with imidazolium cations, other glassy matrix compatible ionic liquids include those containing pyrrolidinium, phosphonium, ammonium, sulfonium, and pyridinium cations. Examples of pyrrolidinium cation [Pyrr]⁺ based ILs include N-butyl-N-methylpyrrolidinium bis(trifluoromethane sulfonyl)imide [BuMePyrr]⁺[TFSI]⁻; N-ethyl-N-methylpyrrolidinium bis(fluoro sulfonyl)imide [EtMePyrr]⁺[FSI]⁻; and N-methyl-N-propylpyrrolidinium bis(fluorosulfonyl)imide [MePrPyrr]⁺[FSI]⁻. The pyrrolidinium cation along with piperidinium-based [Pyr]⁺ ILs are less likely to disrupt the glassy polymer matrix. Similarly fluorine-based FSI anions are intrinsically compatible with fluorinated systems. Piperidinium [Pip]⁺ cation ILs include N-butyl-N-methylpiperidinium bis(trifluoromethanesulfonyl)imide [BuMePip]⁺[TFSI]⁻ and N-ethyl-N-methylpiperidinium bis(fluoro sulfonyl)imide [EtMePip]⁺[FSI]⁻.

High thermal stability phosphonium-based ionic liquids compatible with glassy matrix IEMs include trihexyl(tetradecyl)phosphonium bis(trifluoromethanesulfonyl)imide [P6,6,6,14]⁺[TFSI]⁻ and trihexyl(tetradecyl)phosphonium dicyanamide [P6,6,6,14]⁺[DCA]⁻. Ammonium [Am]⁺ cation ILs characterized by superior conductivity in electrochemical applications such as proton exchange membranes and battery separators and high temperature operation include N,N-diethyl-N-methyl-N-(2-methoxyethyl)ammonium bis(trifluoromethanesulfonyl)imide [(DEt)(MeOEt)Am]⁺[TFSI]⁻ and tetraethylammonium bis(trifluoromethanesulfonyl)imide [TEtAm]⁺[TFSI]⁻.

Sulfonium-based ILs compatible with glassy matrix IEMs include triethylsulfonium bis(trifluoromethanesulfonyl)imide [TEtS]⁺[TFSI]⁻ and trimethylsulfonium bis(fluorosulfonyl)imide [TMeS]⁺[FSI]⁻. Pyridinium-based ionic liquids include N-butylpyridinium bis(trifluoromethane sulfonyl)imide [BuPyr]⁺[TFSI]⁻ and N-methylpyridinium tetrafluoroborate [MePyr]⁺[BF₄]⁻.

A number of ionic liquids are similarly incompatible with specific composition ion exchange membranes. For example, 1-butyl-3-methylimidazolium chloride [BuMeIm]⁺[Cl]⁻ exhibits poor compatibility due to strong ionic interactions that can disrupt the polymer matrix. 1-ethyl-3-methylimidazolium acetate [EtMeIm]⁺[OAc]⁻ exhibits strong hydrogen bonding interactions leading to phase separation in fluorinated polymers. For a 1-butyl-3-methylimidazolium nitrate [BuMeIm]⁺[NO₃]-ionic liquid the presence of nitrate ions can cause instability and poor compatibility with fluorinated matrices. In the case of 1-butyl-3-methylimidazolium thiocyanate [BuMeIm]⁺[SCN]⁻ the thiocyanate [SCN]⁻ anion can interact unfavorably with the polymer, leading to poor compatibility.

Ionic liquids containing phosphate anions such as 1-butyl-3-methylimidazolium phosphate [BuMeIm]⁺[H₂PO₄]⁻ can cause phase separation and instability in the polymer matrix. In the case of 1-ethyl-3-methylimidazolium hydrogen sulfate [EtMeIm]⁺[HSO₄]⁻, the hydrogen sulfate anion can lead to strong ionic interactions that are not favorable for fluorinated polymers. For butyl-3-methylimidazolium formate [BuMeIm]⁺[HCOO]⁻, the formate anion [HCOO]-can lead to unfavorable interactions with fluorinated polymers, causing phase separation and instability. Despite having a fluorinated anion, ionic interactions of ethyl-3-methylimidazolium trifluoromethanesulfonate [EtMeIm]⁺[OTf]⁻ may still suffer poor compatibility with certain fluorinated polymers.

Depending on composition, even imidazolium based ILs can suffer phase separation and incompatibility with glassy matrix IEMs. Especially in cases of chlorine [Cl]⁻ and bromine [Br]⁻ present within butyl-3-methylimidazolium chloride [BuMeIm]⁺[Cl]⁻ and 1-butyl-3-methylimidazolium bromide [BuMeIm]⁺[Br]⁻, highly electronegative anions may actually damage the ionomeric membrane.

### IL-Doped Polyethylene (PE) IEMs.

Proton exchange membranes (PEMs) comprising polyethylene (PE) described in § 4 typically require ionic liquids (ILs) that are chemically compatible and do not cause significant degradation or swelling. the IL should not degrade or react with the polymer. Desirable properties of the IL include (a) thermal stability, i.e. maintaining its properties at the operating temperatures of the PEM, (b) ionic conductivity i.e. where IL should enhance ionic conductivity to facilitate the desired electrochemical processes, (c) low viscosity where the IL is sufficiently fluid to enhance ionic mobility for efficient charge transport, and (d) compatibility with the IEM to avoid damage to the membrane or its ionomers.

Here are some ionic liquids that in accordance with the foregoing are generally considered more compatible with PE-based PEMs, they include 1-ethyl-3-methylimidazolium tetrafluoroborate [EtMeIm]⁺[BF₄]⁻, a relatively stable IL unlikely to interact aggressively with polyethylene; 1-butyl-3-methylimidazolium tetrafluoroborate [BuMeIm]⁺[BF₄]⁻ which similarly comprises a stable anion unreactive with PE; and 1-ethyl-3-methylimidazolium bis(trifluoromethylsulfonyl)imide [EtMeIm]⁺[NTf₂]⁻. The [NTf₂]⁻ anion is known for its chemical stability and low reactivity, making it a good candidate for use with polyethylene membranes. Another ionic liquid is 1-butyl-3-methylimidazolium bis(trifluoromethylsulfonyl)imide [BuMeIm]⁺[NTf₂]⁻. Like [EtMeIm]⁺[NTf₂]⁻, this IL has a low reactivity and high chemical stability, making it suitable for use with PE-based PEMs along with 1-ethyl-3-methylimidazolium dicyanamide [EtMeIm]⁺[DCA]⁻ offering good compatibility with various polymers, including polyethylene.

Similarly, 1-butyl-3-methylimidazolium dicyanamide [BuMeIm]⁺[DCA]⁻, 1-butyl-3-methyl imidazolium hexafluorophosphate [BuMeIm]⁺[PF₆]⁻ and 1-ethyl-3-methylimidazolium tetrafluoro-borate [EtMeIm]⁺[BF₄]⁻ offer characteristics compatible with PE membranes in electrochemical applications. Some ILs may comprise more chemically aggressive acetate and chloride anions but can still be paired with imidazolium based cations when doping PE membranes. These ILs include 1-ethyl-3-methylimidazolium acetate [EtMeIm]⁺[OAc]⁻ and 1-butyl-3-methylimidazolium chloride [BuMeIm]⁺[Cl]⁻.

Certain ionic liquids are unsuitable for use in polyethylene ion exchange membranes causing chemical reactions or physical interactions detrimental to the integrity and performance of polyethylene (PE) ion exchange membranes. Primarily through adverse reactions with chemically aggressive anions, ILs may degrade the polymeric support structure or damage the electrochemically active ionomer, especially those including certain chloride, bromide, phosphate, acetate, and dicyanamide. Examples include 1-butyl-3-methylimidazolium chloride [BuMeIm]⁺[Cl]⁻, 1-ethyl-3-methylimidazolium acetate [EtMeIm]⁺[OAc]⁻, butyl-3-methylimidazolium tetrafluoro borate [BuMeIm]⁺[BF₄]⁻, 1-hexyl-3-methylimidazolium hexafluorophosphate [HexMeIm]⁺[PF₆]⁻, 1-octyl-3-methylimidazolium bis(trifluoromethylsulfonyl)imide [OctMeIm]⁺[Tf₂N]⁻, and 1-butyl-3-methyl imidazolium dicyanamide [BuMeIm]⁺[DCA]⁻.

### IL-Doped Polyvinyl Alcohol (PVA) IEMs.

Ionic liquids compatible with polyvinyl alcohol (PVA) based ion exchange membranes in § 5 include both imidazolium and non-imidazolium cation types. These include 1-butyl-3-methylimidazolium chloride [BuMeIm]⁺[Cl]⁻; 1-ethyl-3-methylimidazolium acetate [EtMeIm]⁺[OAc]⁻; 1-hexyl-3-methylimidazolium hexafluorophosphate [HexMeIm]⁺[PF₆]⁻; 1-butyl-3-methyl imidazolium tetrafluoroborate [BuMeIm]⁺[BF₄]⁻; and 1-ethyl-3-methylimidazolium trifluoro methane sulfonate [EtMeIm]⁺[OTf]⁻. Non-imidazolium ILs compatible with PVA membranes include 1-butyl-1-methylpyrrolidinium bis(trifluoromethylsulfonyl)imide [BuMePyrr]⁺[NTf₂]⁻; tetrabutyl-ammonium bromide [TBuAm]⁺[Br]⁻; tetrabutylphosphonium chloride [TBuP]⁺[Cl]⁻; N,N-diethyl-N-methyl-N-(2-methoxyethyl)ammonium bis(trifluoromethylsulfonyl)imide [DEt(MeEt)Am]⁺ [NTf₂]⁻; triethylsulfonium bis(trifluoromethylsulfonyl)imide [TEtS]⁺[NTf₂]⁻; 1-butyl-1-methyl pyrrolidinium dicyanamide [BuMePyrr]⁺[DCA]⁻; and choline dihydrogen phosphate [Cho]⁺[DHP]⁻.

Some ionic liquids incompatible with or potentially damaging to PVA-based PEMs include chemical degradation, excessive swelling, or plasticization of the PVA matrix. Specifically, anions containing chloride [Cl]⁻ and sulfonate [OTf]⁻ which can cause chemical instability and degradation in polyvinyl acetate include 1-butyl-3-methylimidazolium chloride [BuMeIm]⁺[Cl]⁻; 1-hexyl-3-methylimidazolium chloride [HexMeIm]⁺[Cl]⁻; 1-ethyl-3-methylimidazolium trifluoromethane-sulfonate [EtMeIm]⁺[OTf]⁻; and 1-butyl-3-methylimidazolium trifluoromethanesulfonate [BuMeIm]⁺[OTf]⁻. ILs containing acetate and tetrafluoroborate anions react aggressively with the PVA polymer causing hydrolysis, significant swelling, membrane degradation, and damage to the chemical integrity of the PVA matrix. These include 1-ethyl-3-methylimidazolium acetate [EtMeIm]⁺[OAc]⁻; 1-butyl-3-methylimidazolium acetate [BuMeIm]⁺[OAc]⁻; and 1-butyl-3-methylimidazolium tetrafluoroborate [BuMeIm]⁺[BF₄]⁻.

### IL-Doped Polyvinyl Difluoride (PVDF) IEMs.

Ionic liquids compatible with polyvinyl difluoride (PVDF) described in § 6 based proton exchange membranes include both imidazolium and non-imidazolium cation ionic liquids. Ionic liquids with [Im]⁺ cations include 1-butyl-3-methylimidazolium tetrafluoroborate [BuMeIm]⁺[BF₄]⁻; 1-ethyl-3-methylimidazolium trifluoromethanesulfonate [EtMeIm]⁺[OTf]⁻; and 1-hexyl-3-methylimidazolium hexafluoro phosphate [HexMeIm]⁺[PF₆]⁻. Non-imidazolium-based ionic liquids compatible with PVDF proton exchange membranes include ammonium, sulfonium, and pyrrolidinium cations such as tetrabutylammonium tetrafluoroborate [TBuAm]⁺[BF₄]⁻; triethyl sulfonium bis(trifluoromethyl sulfonyl)imide [TEtS]⁺[TFSI]⁻; N-methyl-N-propylpyrrolidinium bis(trifluoro methylsulfonyl)imide [MePrPyrr]⁺[TFSI]⁻.

Ionic liquids which can degrade or damage the PVDF proton exchange membrane due to chemical reactivity or incompatibility with the polymer structure include those containing chemically aggressive anions such as chlorides or acetates exemplified by 1-butyl-3-methylimidazolium chloride [BuMeIm]⁺[Cl]⁻; 1-ethyl-3-methylimidazolium acetate [EtMeIm]⁺[OAc]⁻; 1-hexyl-3-methylimidazolium chloride [HexMeIm]⁺[Cl]⁻; tetrabutylphosphonium chloride [TBuP]⁺[Cl]⁻; and N-methyl-N-propylpyrrolidinium chloride [MePrPyrr]⁺[Cl]⁻.

### IL-Doped Polyvinyl Chloride (PVC) IEMs.

Using ionic liquid doping of poly vinyl chloride membranes described in § 8 made in accordance with this invention can benefit from enhanced conductivity and improved mechanical stability. IL dopants may comprise imidazolium and non-imidazolium moieties.

Exemplary PVC compatible imidazolium ionic liquids include 1-butyl-3-methylimidazolium tetrafluoroborate [BuMeIm]⁺[BF₄]⁻; 1-ethyl-3-methylimidazolium bis(trifluoromethylsulfonyl)imide [EtMeIm]⁺[Tf₂N]⁻; and 1-hexyl-3-methylimidazolium hexafluorophosphate [HexMeIm]⁺[PF₆]⁻; Non-imidazolium-based ILs compatible with poly vinyl chloride ionomers include tetraethylammonium tetrafluoroborate [TEtAm]⁺[BF₄]⁻; methylpyridinium tetrafluoroborate [MePyr]⁺[BF₄]⁻; and choline dihydrogen phosphate [Cho]⁺[DHP]⁻.

Ionic liquids incompatible with or potentially harmful to PVC PEMs include those containing reactive chloride and acetate anions such as 1-butyl-3-methylimidazolium chloride [BuMeIm]⁺[Cl]⁻; 1-hexyl-3-methylimidazolium chloride [HexMeIm]⁺[Cl]⁻; N-methyl-N-propyl-piperidinium chloride [MePrPip]⁺[Cl]⁻; and 1-ethyl-3-methylimidazolium acetate [EtMeIm]⁺[OAc]⁻. Through a different reaction also adverse to the PEM's structure, highly basic hydroxide anions such as tetrabutylammonium hydroxide [Bu₄N]⁺[OH]⁻ can cause hydrolytic degradation of the polyimide.

### IL-Doped Polyimide (PI) IEMs.

Made in accordance with this invention, polyimide (PI) ion exchange membranes described in § 9 may also be doped with ionic liquids comprising either imidazolium or non-Imidazolium cations. IL-doped polyimide membranes with [Im]⁺ cations include 1-butyl-3-methylimidazolium bis(trifluoromethylsulfonyl)imide [BuMeIm]⁺[Tf₂N]⁻; 1-ethyl-3-methyl-imidazolium tetrafluoroborate [EtMeIm]⁺[BF4]⁻; and 1-hexyl-3-methylimidazolium bis(trifluoro-methylsulfonyl)imide [HexMeIm]⁺[Tf₂N]⁻. Non-imidazolium-based ionic liquids compatible with polyimide proton exchange membrane include tetrabutylphosphonium bis(trifluoromethyl-sulfonyl)imide [Bu₄P]⁺[Tf₂N]⁻; N-methyl-N-propylpyrrolidinium bis(trifluoro methylsulfonyl)imide [MePrPyrr]⁺[Tf₂N]⁻; and tetrabutylammonium bis(trifluoromethyl sulfonyl)imide [Bu₄N]⁺[Tf₂N]⁻.

Ionic liquids incompatible with or potentially harmful to polyimide PEMs include those containing reactive chloride and acetate anions such as 1-butyl-3-methylimidazolium chloride [BuMeIm]⁺[Cl]⁻; 1-hexyl-3-methylimidazolium chloride [HexMeIm]⁺[Cl]⁻; N-methyl-N-propyl-piperidinium chloride [MePrPip]⁺[Cl]⁻; and 1-ethyl-3-methylimidazolium acetate [EtMeIm]⁺[OAc]⁻. Through a different reaction also adverse to the PEM's structure, highly basic hydroxide anions such as tetrabutylammonium hydroxide [Bu₄N]⁺[OH]⁻ can cause hydrolytic degradation of the polyimide.

### IL-Doped Polystyrene (PS) IEMs.

Using ionic liquid doping of polystyrene (PS) of § 10 membranes made in accordance with this invention can benefit from enhanced conductivity and improved mechanical stability. IL dopants may comprise imidazolium and non-imidazolium moieties.

Exemplary PS compatible imidazolium ionic liquids include 1-butyl-3-methylimidazolium tetrafluoroborate [BuMeIm]⁺[BF₄]⁻; 1-ethyl-3-methylimidazolium bis(trifluoromethylsulfonyl)imide [EtMeIm]⁺[Tf₂N]⁻; and 1-hexyl-3-methylimidazolium hexafluorophosphate [HexMeIm]⁺[PF₆]⁻; Non-imidazolium-based ILs compatible with polystyrene ionomers include tetraethylammonium tetrafluoroborate [TEtAm]⁺[BF₄]⁻; methylpyridinium tetrafluoroborate [MePyr]⁺[BF₄]⁻; and choline dihydrogen phosphate [Cho]⁺[DHP]⁻.

Ionic liquids incompatible with or potentially harmful to PS PEMs include those containing reactive chloride and acetate anions such as 1-butyl-3-methylimidazolium chloride [BuMeIm]⁺[Cl]⁻; 1-hexyl-3-methylimidazolium chloride [HexMeIm]⁺[Cl]⁻; N-methyl-N-propyl-piperidinium chloride [MePrPip]⁺[Cl]⁻; and 1-ethyl-3-methylimidazolium acetate [EtMeIm]⁺[OAc]⁻. Through a different reaction also adverse to the PEM's structure, highly basic hydroxide anions such as tetrabutylammonium hydroxide [Bu₄N]⁺[OH]⁻ can cause hydrolytic degradation of the polyimide.

### IL-Doped Polyphenylene (PPh) IEMs.

IL doping of polyphenylene (PPh) described in § 12 may comprise either imidazolium and non-imidazolium cations. Imidazolium [Im]⁺ based ILs compatible with PPh membranes include 1-butyl-3-methylimidazolium tetrafluoroborate [BuMeIm]⁺[BF₄]⁻; 1-ethyl-3-methylimidazolium trifluoromethanesulfonate [EtMeIm]⁺[OTf]⁻; and 1-hexyl-3-methyl-imidazolium bis(trifluoromethylsulfonyl)imide [HexMeIm]⁺[NTf₂]⁻. Non-imidazolium-based ionic liquids compatible with polyphenylene proton exchange membranes ammonium, pyridinium, and phosphonium moieties including tetraalkylammonium bis(trifluoromethylsulfonyl)imide [(H(CH₂)ₙ)₄N]⁺[NTf₂]⁻; alkylpyridinium bis(trifluoromethylsulfonyl)imide [(H(CH₂)ₙ)Pyr]⁺[NTf₂]⁻; and alkyl-phosphonium bis(trifluoromethylsulfonyl)imide [(H(CH₂)ₙ)₄P]⁺[NTf₂]⁻ comprising alkyl chains of length ‘n’.

For example when n=2 (ethyl) for tetraalkylammonium, the cation may be referred to as tetraethylammonium denoted as [TEtAm]⁺ or by the numeric code [N2222]⁺ where each number denotes the length of each of the four functional groups. For alkyl-phosphonium where n=4 (butyl) for all four functional groups, the cation may be called tetrabutylphosphonium denoted by [TEtAm]⁺ or by the numeric code [P2222]⁺. The functional groups of a IL cation need not contain identical length carbon chains. For example, in the tripropyl dodecyl phosphonium cation [(H(H₂C)₁₂)(Pr)₃P]⁺ or [(Dodec)(Pr)₃P]⁺ three chains comprise n=3 (propyl) groups and one chain comprises a n=12 (dodecyl) group. For shorthand, the IL cation can be identified as [P33312]⁺.

Ionic liquids incompatible or harmful to polyphenylene proton exchange membranes include those contain chloride, acetate, or hydroxide anions such as 1-butyl-3-methylimidazolium chloride [BuMeIm]⁺[Cl]⁻; 1-ethyl-3-methylimidazolium acetate [EtMeIm]⁺[Ac]⁻; 1-butyl-3-methylimidazolium hydroxide [BuMeIm]⁺[OH]⁻; tetraalkylammonium chloride such as [N2222]⁺[Cl]⁻; and methyl-pyridinium chloride [MePyr]⁺[Cl]⁻.

### IL-Doped Poly Ether Heteropolymer IEMs.

A variety of ion exchange membranes involve poly ether heteropolymers described in sections 11, 13, 14, and 15 including poly ether ketones, poly ether sulfones, poly ether ketone sulfones, polyarylene ethers, and poly fluorenyl ether ketone nitriles. Common to these various classes of ionomeric membranes is ether Et₂O, an linear organic compound comprising an oxygen center surrounded by two ethyl groups. It can also be expressed as (C₂H₅)₂O or as the n=2 carbon chain (H(CH₂)₂)₂O. Unlike the ethyl functional groups in alkyl sidechains, in poly ether membranes and related moieties such PEKN, PEK, PEEK, PAE, etc. the ether group forms the backbone of the polymer. The addition of ionic liquid doping into a poly ether based IEM must not degrade this relatively volatile component.

IL doping of poly ether based membranes made in accordance with this invention comprise both imidazolium and non-imidazolium cations including 1-ethyl-3-methylimidazolium trifluoro-methanesulfonate [EtMeIm]⁺[TfO]⁻; 1-butyl-3-methylimidazolium tetrafluoroborate [BuMeIm]⁺[BF₄]⁻; and 1-hexyl-3-methylimidazolium bis(trifluoromethylsulfonyl)imide [HexMeIm]⁺[NTf₂]⁻. Non-imidazolium-based ionic liquids compatible with poly ether PEM moieties include tetraethyl ammonium bis(trifluoromethylsulfonyl)imide [TEtAm]⁺[NTf₂]⁻; triethylsulfonium trifluoromethane sulfonate [Et₃S]⁺[TfO]⁻; and N-methyl-N-propylpyrrolidinium bis(trifluoromethylsulfonyl)imide** [MePrPyrr]⁺[NTf₂]⁻.

IL dopants that impair IEM function or damage the polymeric matrix of poly ether related IEMs include the electronegative chloride, bromide, and iodide anions along with acetate and dicyanamide compounds. Examples of poly ether antagonists include 1-butyl-3-ethylimidazolium chloride [BuEtIm]⁺[Cl]⁻; 1-butyl-3-methylimidazolium chloride [BuMeIm]⁺[Cl]⁻; 1-ethyl-3-methyl imidazolium acetate [EtMeIm]⁺[OAc]⁻; 1-butyl-3-methylimidazolium dicyanamide [BuMeIm]⁺[DCA]⁻; and tetrabutylammonium iodide [TBuAm]⁺[I]⁻.

### IL-Doped Polysulfone (PSf) IEMs.

Polysulfone acid-base membranes can also by enhanced using the ionic liquids made in accordance with this invention. IL dopants compatible with polysulfone IEMs comprising imidazolium cations include 1-butyl-3-methylimidazolium tetrafluoroborate [BuMeIm]⁺[BF₄]⁻; 1-ethyl-3-methylimidazolium bis(trifluoromethylsulfonyl)imide [EtMeIm]⁺[Tf₂N]⁻; and 1-hexyl-3-methylimidazolium hexafluorophosphate [HexMeIm][PF₆]⁻. Non-imidazolium-based ionic liquids compatible with polysulfone acid-base polymer proton exchange membranes include tetraethylammonium tetrafluoroborate [Et₄N]⁺[BF4]⁻; choline bis(trifluoro methylsulfonyl)imide [Ch]⁺[Tf₂N]⁻; and ethylpyridinium bis(trifluoromethylsulfonyl)imide [EtPyr]⁺ [Tf₂N]⁻.

ILs which can be corrosive and damage or degrade the polysulfone polymer structure include chloride, bromide, and dicyanamide anions. Acetate anions can be reactive causing hydrolysis of the polymer backbone. Exemplary ionic liquids incompatible with polysulfone include 1-butyl-3-methylimidazolium chloride [BuMeIm]⁺[Cl]⁻; 1-methyl-3-octyl imidazolium chloride [MeOctIm]⁺[Cl]⁻; triethylammonium acetate [Et₃NH]⁺[OAc]⁻; 1-hexyl-3-methylimidazolium bromide [HexMeIm]⁺[Br]⁻; and 1-butyl-3-methylimidazolium dicyanamide [BuMeIm]⁺[DCA]⁻.

### IL-Doped Phenylene-Bibenzimidazole (PBI) IEMs.

The doping of phenylene-bibenzimidazole (PBI) ion exchange membranes with ionic liquids include both imidazolium and non-imidazolium cations. These include 1-ethyl-3-methylimidazolium trifluoromethanesulfonate [EtMeIm]⁺[OTf]⁻; 1-butyl-3-methylimidazolium tetrafluoroborate [BuMeIm]⁺[BF₄]⁻; and 1-ethyl-3-methylimidazolium bis(trifluoromethylsulfonyl)imide [EtMeIm]⁺[Tf₂N]⁻. Non-imidazolium-based IL doping of PBI membranes including 1-butyl-1-methylpyrrolidinium bis(trifluoromethylsulfonyl)imide [BuMePyrr]⁺ [Tf₂N]⁻; N-methyl-N-propylpyrrolidinium bis(trifluoromethylsulfonyl)imide [MePrPyrr]⁺[Tf₂N]⁻; tetrabutylammonium bis(trifluoromethylsulfonyl)imide; tetrabutylammonium bis(trifluoromethyl-sulfonyl)imide [NBu₄]⁺[Tf₂N]⁻; and 1-butyl-1-methylpiperidinium bis(trifluoromethylsulfonyl)imide [BuMePip]⁺[Tf₂N]⁻.

Ionic liquids incompatible with PBI ion exchange membranes primarily comprise reactive chloride and bromide anions which can damage the polymeric backbone and its ionomeric groups. They include 1-methyl-3-butylimidazolium chloride [BuMeIm]⁺[Cl]⁻; 1-ethyl-3-methylimidazolium chloride [EtMeIm]⁺[Cl]⁻; 1-butyl-3-methylimidazolium bromide [BuMeIm]⁺[Br]⁻; 1-hexyl-3-methyl imidazolium chloride [HexMeIm]⁺[Cl]⁻; and 1-octyl-3-methylimidazolium chloride [OctMeIm]⁺[Cl]⁻;

### IL-Doped Biopolymer IEMs.

The doping of biopolymer based ion exchange membranes such as chitosan and cellulose with ionic liquids can be used to enhance conductivity but must not degrade the structural matrix of the biopolymer, especially at elevated temperatures. Biopolymer compatible doping comprising imidazolium-based ionic liquids include 1-butyl-3-methylimidazolium chloride [BuMeIm]⁺[Cl]⁻; 1-ethyl-3-methylimidazolium acetate [EtMeIm]⁺[OAc]⁻; and 1-hexyl-3-methylimidazolium tetrafluoroborate [HexMeIm]⁺[BF₄]⁻. Non-imidazolium-based ionic liquids compatible with biopolymer IEMs include tetrabutylammonium bromide [TBuAm]⁺[Br]⁻; choline dihydrogen phosphate [Ch]⁺[DHP]⁻; and methylpyridinium chloride [Pyr]⁺[Cl]⁻.

Conversely ionic liquids potentially harmful to biopolymers comprise those that attacked the fibrous backbone of the biopolymer such as hexafluorophosphate, trifluoromethylsulfonyl, and dicyanamide radicals. These include the exemplary ionic liquids 1-butyl-3-methylimidazolium hexafluorophosphate [BuMeIm][PF₆]⁻; 1-hexyl-3-methylimidazolium hexafluorophosphate [HexMeIm]⁺[PF₆]⁻; 1-ethyl-3-methylimidazolium bis(trifluoromethylsulfonyl)imide [EtMeIm]⁺[Tf₂N]⁻; 1-butyl-3-methyl-imidazolium dicyanamide [BuMeIm]⁺[DCA]⁻; and 1-hexyl-3-methyl imidazolium bis(trifluoromethyl sulfonyl)imide [HexMeIm]⁺[Tf₂N]⁻.

### IL-Doped Copolymers and Hybrid IEMs.

Copolymers and hybrid ion exchange membranes contain an amalgamate or blend of more than one polymer forming the ionomeric membrane. Like homopolymers, the chemistry of an ionic liquid dopant must not damage of disturb the structural integrity of the constituent polymeric backbones of the IEM. Since many of these copolymers use polymers described previously, the suitability of an ionic liquid cation and anion in a hybrid membrane is governed by the same rules as its constituent homopolymers.

Made in accordance with this invention, the PFSA polypropylene copolymer (PFSA-co-PP) described in § 7 follows the same recommendation for suitable and unsuitable ILs described in § 1 and § 2 for PFSA homopolymers and PFSA-PTFE CRMs. Similarly the hybrid glassy copolymers such as (PFMMD-co-X) of § 18 and (PDD-co-X) of § 19 adhere to the same guidelines as the glassy membranes of § 3.

Comprising aromatic cyclic rings, the hybrid phenyl copolymer (phenyl-co-X) of § 20 and hybrid styrene copolymers (styrene-co/g-X) in § 21 structurally resemble that of polystyrene described in § 10. As such, the recommended choice for applicable and hostile ILs used in hybrid phenyl copolymer are substantially equivalent.

Similarly hybrid polysulfone P(Sf-sSf) described in § 22 follows the same guidelines as that of polysulfone acid-base polymer (PSf) described in § 37. Hybrid polyamide membranes P(Am-co-SAm) discussed in § 23 are compatible with polyimides described in § 9.

Hybrid poly phosphazene P(Pz-co-sPz) in § 24 and hybrid poly siloxane P(SiX-co-sSiX) in § 25 are often combined with a mutually compatible with thermoplastics such as polyethylene described in § 4. Hybrid triazine (CTP) polymers in § 26 shares aromatic structural similarities and I_{L} compatibility with polysulfone membranes described in § 15. Phosphazene is also mutually compatible with PVDF discussed in § 6.

Ionic liquids compatible with hybrid methacrylate copolymer P(MMA-co-X) in § 27 are similar to those applicable to amorphous glassy matrices such as PFMMD in described in § 6. Based on a cellulose backbone, hybrid poly carboxy methyl cellulose (CMC) described in § 28 is similarly compatible with ion liquid used with biopolymers described in § 39. Hybrid poly multi-acid sidechain (MASC, PFIA) membranes described in § 29 are compatible with the same ILs used with PFSA homopolymers and PFSA-PTFE CRMs described in § 1 and § 2. Unsurprisingly hybrid poly arylene-ether (PAE) is § 30 similar to polyarylene ether (PAE) described in § 13.

### § 41. Block Copolymers.

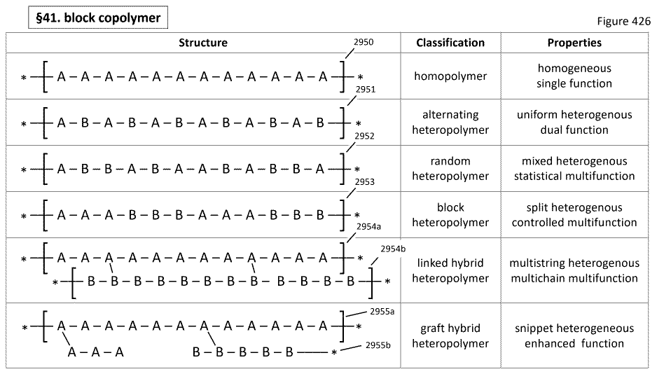

A block polymer represents a copolymer comprising two different polymers chemically bound together to form one or more heterogenous polymer backbones. The topological relationships of the blocks are represented graphically in FIG. 426. As shown, homopolymer 2950 comprises a uniform polymer formed by repeated units of ‘A’ monomers.

By contrast, the alternating heteropolymer 2951 comprises two segments ‘A’ and ‘B’ arranged in alternating fashion. A backbone of alternating short polymer snippets is not considered a block polymer because its chain components are too short to determine the physical or electrical properties of the chain. For example, a PFSA-PTFE composite reinforced membrane is not classified as a block polymer because the polymer PTFE is the same as PFSA except it lacks the attached sidechain.

A true block polymer 2953 is a polymeric chain where one or both segments are distinct and sufficiently lengthy to influence the physical and electrochemical properties of the polymer. By contrast linked hybrid heteropolymers 1954a and 2954b are simply cross-linked chains of dissimilar polymers but do not constitute block polymers. Cross linked polymers are discussed throughout this application and will not be repeated here except to mention the cross linking requires an intermediate cross linking molecule not unlike those required to bond the IEM film to the inert pillar of the endoskeleton structure described herein.

Similarly, cross linked polymers require a cross linker, a molecule that has a functional group or two termini one that bonds to polymer ‘A’ the other to polymer ‘B’. In the fabrication process of linked hybrid heteropolymer 2954a and 2954b, polymer A and B can be formed first then cross linked or more commonly formed concurrently in the presence of the cross-linking molecule. The grafting of one polymer onto another such as graft hybrid heteropolymer comprising mainchain 2955a and graft chain 2955b is normally performed sequentially. In essence the only true block structure is block heteropolymer 2953.

Cross linkers include glutaraldehyde (GA); sulfonated glutaraldehyde (sGA); glyceraldehyde; formaldehyde; divinyl benzene (DVB); epichlorohydrin (ECH), p-hydroxymethyl benzyl chloride (HMe-BnCl), divinyl benzene (DVBz); and dibenzoyl peroxide (DBPO); 2-dihydro-4-(4-hydroxyphenyl)-1 (2H)-phthalazone (DHPhthal); peroxide (H₂O₂); dithiol (DT), dithiol (DT), bishydroxy perfluoropolyether (PFPE); sodium borohydride (NaBH); bis(hydroxymethyl) (CH₃O); N,N-dimethylformamide (DMF); N,N-dimethylacetamide (DMAc); N-methyl pyrrolidone (NMP); and biphenyl A (BPA), benzene (Bz); benzyl alcohol (BnOH, cresol); perfluorodibenzoyl peroxide ((FBzO)₂, FBzO), perfluoro-di-tert-butyl peroxide (FDTBO); perfluoro-dimethyl-dioxolane (PFDMO); p-hydroxymethyl benzyl chloride (OHMe-BnCl); 4,4′-trimethylene bis(1-methylpiperidine) (BMP); photo-induced 2,4,6-trimethylbenzoyl-diphenyl-phosphine oxide (photo TPO); trimethylolpropane tri-acrylate (TMPTA); E-caprolactam (CPL, (CH₂)₅CNH); sulfonamide (SAm); anhydrous aluminum chloride (AlCl₃); trichlorobenzene (TCB); hydrous calcium sulfate (CaSO₄·2H₂O); sulfamic acid (HSO₃ (NH₂)); benzoyl peroxide (BPO, (BzO)₂); tert-butyl peroxypivalate (tBPPiv); thiol-containing chain transfer agents (CTAs); dithiol (DT), sulfonated dithiol (SDT); 4,4′-trimethylene bis(1-methylpiperidine) (BMP); trimethylolpropane tri-acrylate (TMPTA); phenyl (Ph); methylated phenyl (MePh); α,α′-dibromo-p-xylene (DBpX or PhBr₂); 1,3,5-tris(bromomethyl)-2,4,6-triethylbenzene (BeBr₃); p-xylylene dichloride (PhCl₂, C₈H₈Cl₂); divinyl sulphone ((CH₂═CH)₂SO), 1,3,5-tris-(bromomethyl)benzene (B₃Br); benzoxazine (C₁₄H₁₃NO), hexachlorocyclotriphosphazene HCCP; imidazolechlorocyclotriphosphazene (ImCCP); polyoctahedral silsesquioxanes (X-L) POSS); and sulfate anion groups (SO₄-).

Depending on polymer chemistry acid and bases may also form cross links. Examples include citric acid (C₆H₅(O₇)³⁻); acetic acid (AcOH), glycolic acid (C₂H₄O₃), ethyl lactate (Acytol, lactic acid, C₅H₁₀O₃), pyruvic acid (Pyr, C₃H₄O₃), butyric acid (C₃H₇COOH); sulfuric acid (H₂SO₄, SA); hydrochloric acid (HCl); strong bases such as sodium hydroxide (NaOH) or potassium hydroxide (KOH); Lewis acids comprising metal salts such as aluminum chloride (AlCl₃) or zinc chloride (ZnCl₂); and carboxylic acids; i.e. acids containing carboxyl (—COOH) functional groups such as formic acid (methanoic acid, HCOOH), and carbonic acid (hydroxymethanoic acid, H₂CO₃); along with quaternary ammonia compounds including 1,4-diazabicyclo-[2.2.2]-octane (DABCO), quinuclidine, and quinuclidinol. Heat and ultraviolet light can also promote cross linking between and among homopolymer and heteropolymer chains.

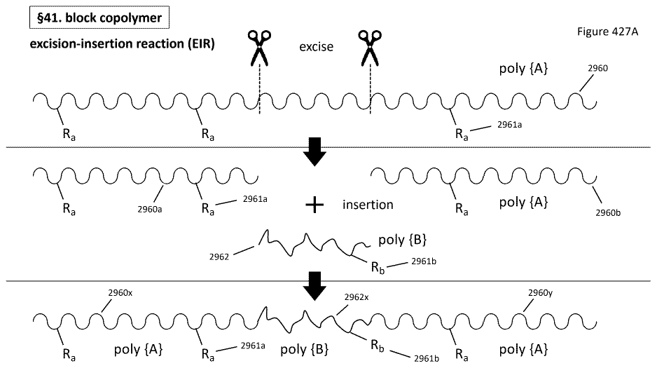

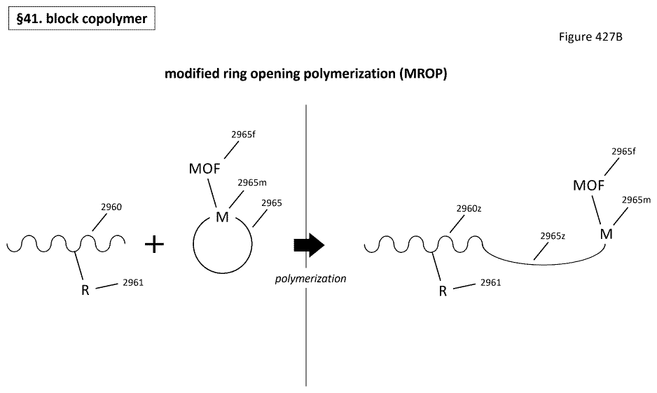

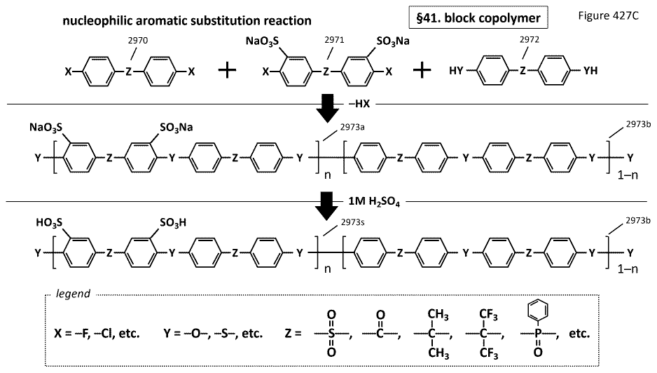

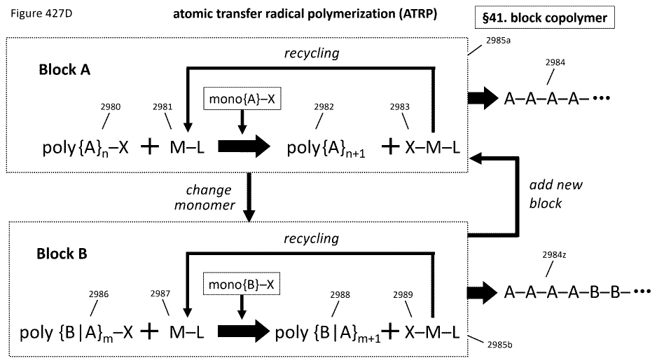

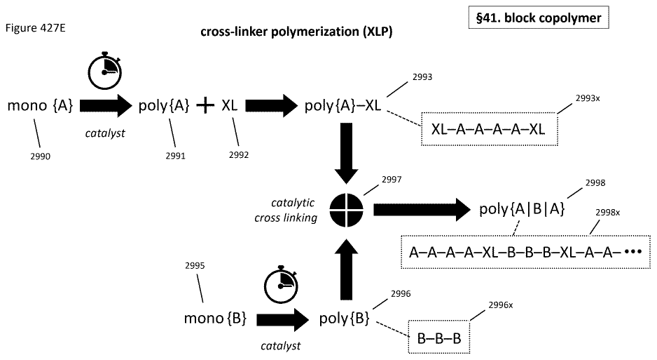

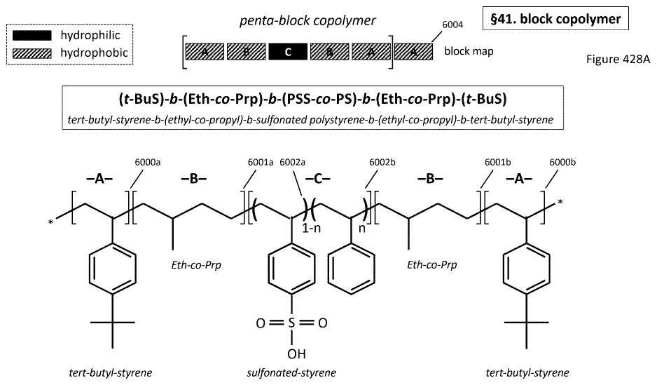

The challenge in forming a block copolymer is how to define the length of the dissimilar segments of the block polymer. One method to form a block copolymer IEM made in accordance with this invention is to employ an excision-insertion reaction. As shown in FIG. 427A, the process involves using a molecule scissor to cleave polymer poly {A} 2960 containing functional groups Ra 2961a, resulting in polymer segments 2960a and 2960b.

Polymer {B} 2962 with functional group radical R_{b} 1961b is then bonded onto the freshly cleaved polymer {A} segments and subsequently annealed to form the block copolymer containing the sequenced blocks 2960x, 2962x, 2960y resulting in a heteropolymer {A|B|A} containing two distinct radicals Rₐ 2691a and R_{b} 2691b. Although radicals Rₐ and R_{b} may comprise the same functional group, for example a medium length pendant with a sulfonic acid terminus, the sidechains and ionomers may also differ. For example, radical Rₐ may comprise a short pendant with a phosphoric acid group while radical Rb may be constituted of a long sidechain or PFIA pendant with a sulfonic acid ionomeric terminus. The assembly of block polymers containing differing sidechains and ionomer termini represents a new class of membrane suitable for numerous applications including filtration, chemical separation, battery separators, as well as fuel cell ion exchange membranes.

Another method to form a heterogenous block copolymer made in accordance with this invention involves bonding a cyclic ring to a linear copolymer through a process referred to as a ‘modified ring opening polymerization’ (MROP). As depicted in FIG. 427B, using a solvent and catalyst cyclic ring 2965 with metal atom M 2965m unfolds to form a linear chain 2965z while bonding to linear chain 2960 with radical R 2961. Radical R may comprise either catalytic or ionomeric functions. Once the ring unfolds, the two linearized polymer chains bond together form a block copolymer {A|B} comprising segments 2960z and 2965z. In the modified ROP process, the metal group M 2965m form a bond to or is a constituent element of a metal organic framework 1965f. The MOF 2965f may perform any number of functions described previously in this application including catalysis, enhanced conduction, or toxic gas scavenging.

An alternative method, a ‘nucleophilic aromatic substitution reaction’ while more easily executed, produces polymer segments of varying lengths. As depicted in FIG. 427C, three biphenyl monomers 2970, 2971, and 2972 contain various on-chain components X, Y, and Z where X represents halogen anions —F, —Cl, —Br, etc.; Y represents covalently bonding elements such as —O— and —S—; and where Z contains a various compounds including O═S═O, C═O, H₃C—C—CH₃, F₃C—C—CF₃, and Ph-P═O. All three monomers contain a central Z molecule. In the case of monomer 2970 and 2971, the monomer termini comprise the halogens X while in the case of monomer 2972, the edge molecules comprise protonated Y, i.e. HY. Of the three monomers, only 1971 is functionalized by a sodium sulfite side group NaSO₃. During processing the monomers are mixed together and catalyzed by the anion —HX to form block polymer {A|B} comprising segments 2973a and 2973b where X matches the halogen of the monomers. In a final step, the block polymer is sulfonated by 1M H₂SO₄. In this process, the sodium atoms in the NaSO₃ functional groups are replaced by hydrogen to form SO₃H in block polymer 2973s, the ionomer sulfonic acid. Although block 2973a of length ‘n’ converts to 2973s, the corresponding block 2973b having a length of (1-n) remains undisturbed.

Another method to form a block copolymer made in accordance with this invention is to adapt a nucleophilic aromatic substitution reaction as shown in FIG. 427D. In this process, polymer {A}n of length ‘n’ previously bonded to X, typically a halogen anion such as Cl⁻ is reacted with a metal-ligand molecule M-L 2981 containing a copper compound together with the monomer (mono{A}-X) to form a longer polymer {A}n+₁ 1982 and a secondary byproduct of halogen X bonded to the metal-ligand compound to form X-M-L 2983.

The X-M-L 2983 complex is then recycled by removing the halogen to recover a nascent metal-ligand molecule M-L 2981 for the next monomer bonding. The result of repeated cycles of attaching new monomers mono {A} onto the polymer chain {A}ₙ is to grow the length of chain A-A-A-A-••• comprising A-block 2984 one addition at a time, the process of which is referred to as block-A synthesis 2985a. It should be noted when n=0, i.e. the first time through the loop, there is no starting polymer poly {A}ₙ whereby poly {A}₀=mono {A}.

After a desired length of the A-block 2984 is achieved, the sequential synthesis process transitions to block-B synthesis 2985b following the same basic algorithm except that the monomer changes to mono{B}. With each loop, another B polymer group is appended onto the polymer chain. As shown, polymeric chain poly{B|A}ₙ 2986 is combined with metal-ligand 2987 and monomer mono{B}ₘ to form longer polymer poly {B IA}ₙ 2988 with byproduct X-N-L 2989 recycled back into metal-ligand 2987. As such, the chain A-A-A-A-••• comprising A-block 2984 is converted into a block polymer 2984z comprising the sequence A-A-A-A-B-B-•••. The process may be repeated by returning to block A process 2986a to form alternating blocks of {A} and {B} monomers.

A more tractable approach made in accordance with this invention called ‘cross link polymerization’ is to form distinct polymer blocks defined by terminating linking molecules on one of the two polymers and then to merge them together into block copolymers in a subsequent annealing process. Such a process is shown in FIG. 427 where monomer mono {A} 2990 is catalyzed at a controlled rate for a specified time to form polymer poly{A} 2991 after which cross linker XL 2992 is introduced into the polymerization process to bond the ends of the chains with the cross linker XL. The process is then terminated resulting in a polymer (poly{A}-XL) 2993 with an exemplary sequence (XL-A-A-A-A-XL) in snippet 2993X.

In a parallel process, monomer mono{B} 2995 is catalyzed at a controlled rate for a specified time to form polymer poly{B} 2996 with an exemplary sequence (—B—B—B—) in snippet 2996X. In this process, the cross linker XL 2992 is selected to bond to both polymers poly{A} 2991 and poly{B}2996 but is initially attached only to poly{A} 2991. The duration of each polymerization reaction, each monomers' polymerization reaction rate, the catalyst type, and the catalyst concentration together determine the statistical distribution of polymers poly {A} 2991 and polymer poly {B}2996. In general the lengths of the two polymers, herein referred to as snippets, are generally not the same. In this example the length of the {A} and {B} snippets 2991X and 2996X are not the same.

The two dissimilar snippets are then combined in a catalytic cross linking process 2997 to form the block polymer poly {A|B|A} 2998 with an exemplary sequence 2998x of (-A-A-A-A-XL-B-B-B-XL-A-A-•••). In this manner, and two polymers disclosed in this application that share the ability to bond to a common cross linker XL 2992 can be bonded to form a block polymer.

In the event that the two polymers have no affinity to any common cross linker, the two separate cross linker can be attached as the termini of poly{A} 2991 and poly{B} 2996 separately. This process referred to as “click” polymerization requires the two cross linkers to a include complementary structures for bonding the respectively cross linkers XLₐ to XL_{b} to each other, clicking together like toy Legos. The resulting sequence is (-A-A-A-A-XLₐ-XL_{b}-B—B—B-XL-A-A-•••). The click polymerization process is therefore more flexible in bonding dissimilar polymers into a block copolymer than the aforementioned cross-linker polymerization (XLP) technique, but is also more complex and expensive.

### Cross Linking Agents.

The term crosslinker and its designation XL is not intended to be limited to multichain polymers but also includes bonding multiple snippets into a single chain of alternating or random block copolymers. Another name for these linking molecules is ‘chain extenders’. For example as shown previously in FIG. 104, glutaraldehyde (GA) 1062 punctions as a cross linker between polyvinyl alcohol (PVA) 1060 and cellulose acetate (CA) 1061. PVA can also be cross linked via sulfosuccinic acid (SSA) 1066 as depicted previously in FIG. 116. Aside from SSA, other crosslinkers include glyoxal, maleic acid, citric acid, trisodium trimetaphosphate (STMP), sodium hexametaphosphate (SHMP), dianhydrides, and succinic acid (SA).

Other PVA cross linkers include dianhydrides such as 3,3′,4,4′-benzophenone tetracarboxylic dianhydride (BTDA), 4,4′-oxydiphthalic anhydride (ODPA), and pyromellitic dianhydride (PMDA) and on pH sensitive XLs comprising trisodium trimetaphosphate (STMP) and sodium hexametaphosphate (SHMP). Photo-cross-linking agent 4,4′-diazostilbene-2,2′-disulfonic acid disodium salt (DAS) can be used to cross link poly (vinyl pyrrolidone) (PVP) to PFSA. As illustrated in FIG. 118, polyvinyl pyrrolidone (PVA) 1071 also may function as a cross linking agent between polyvinylidene fluoride (PVDF) 1070 and polystyrene sulfonic acid (PSSA) 1073, or in FIG. 120 as a cross linking agent between polyvinylidene fluoride (PVDF) 1070 and sulfonic acid (SA) 1078s.Another cross linking agent, diisopropyl peroxidicarbonate (DIPPDC) is able to bind polyvinylidene fluoride (PVDF) 1070 to hexafluoropropylene (HFP) 1087 as depicted in FIG. 123.

Crosslinking of polyethylene (PE) is used to enhance properties not achievable by polyethylene homopolymers. Crosslinking occurs when the polymer adjacent chains become linked covalently. This bond can be formed directly through carbon-carbon bonds, or indirectly through a bridge-forming group, which creates interchain bridges. Chemical crosslinking of varying densities of PE can be achieved using cross linking agents such as azo, silane or peroxide such as dialkyl peroxide. Dialkyl peroxides such as 2,5-dimethyl-2,5-di(t-butylperoxy)hexane) involves breaking of O—O bonds to form the alkoxyl radical.

In polyimides (PI), cross liking agents shown previously in FIGS. 129 to 131 include diamines 1121 such as 4,4′-diaminodiphenyl ether-2,2′-disulfonic acid (ODADS) 1112; 1,4-bis(4-aminophenoxy-2-sulfonic acid) benzenesulfonic acid (BAPP) 1110; 2,7-bis(4-aminophenoxy) naphthalene (BAPN) 1130; and 4,4′-(9-fluorenylidene) dianiline (9FDA) 1131, and dianhydride 1122 including 4,4′-bisphenol A dianhydride (BPADA) 1111; naphthalene-1,4,5,8-tetracarboxylic dianhydride (NTDA) 1132; 4,4′-oxydiphthalic anhydride (ODPA) 1133; 3,3′,4,4′-diphenylsulfone tetracarboxylic dianhydride (DSDA) 1134.

As shown previously in FIG. 135A, a polystyrene cross linking agent azobisisobutyronitrile (AlBN) is used to form heterogenous n-butyl 4-styrenesulfonate monomers 1150d to be polymerized into poly(styrenesulfonic acid) (PSSA) 1150e and in FIG. 135B to cross link the components into an alternating copolymer styrenesulfonate acid 1151a and 1151b. AlBN also cross links polymethylhydrosiloxane (PMHS) and polymethylvinylsiloxane (PMVS). Poly ether sulfones and ketones can be cross linked by poly(ethylene imine) or as shown previously in FIG. 183B by azobisisobutyronitrile (AlBN).

As shown previously in FIG. 375, cross linkers for p-oxydiphenylene-benzimidazole (PBI) include cross-linking hydroxide comprising 1,4-diazabicyclo-[2.2.2]-octane (DABCO) 2436 and quinuclidinol 2434.

### Exemplary Block Polymers.

Given the aforementioned processes and heterogeneities in film stoichiometry, a nearly infinite number of polymeric membranes are possible. An exhaustive compendia of possible outcomes is neither insightful nor illustrative. And although a specific membrane may be synthesized by a numerous methods as disclosed herein, the mechanical, physical, and electrical properties of such materials are not purely deterministic but vary statistically based on small inhomogeneities in the chemical mix, temperature distribution, solvent concentration, and catalytic reaction rates. Many of these processes are non-linear, reactions where pursuant to thermodynamic constraints a small perturbation in an initial condition or dynamic variations of process parameters produce a significant impact on the chemical reaction product (the butterfly effect). Prescribing the formation of block copolymers is even more complex as the synthesis of each block contained within the chain occurs at its own reaction rate independent of the other blocks.

As such, the exemplary block copolymers as shown herein are included not only to support enablement of the methods disclosed herein but to illustrate the diversity in reaction products when synthesizing copolymer ion exchange membranes. Each copolymer block is identified in a ‘block map’ as either hydrophilic, hydrophobic, or cross linking with brackets identifying the repeating sequence as applicable.

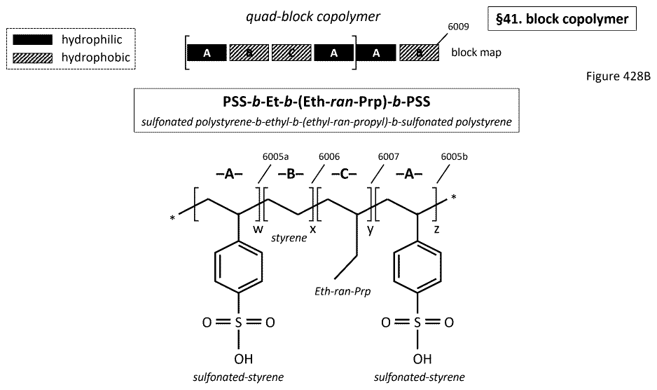

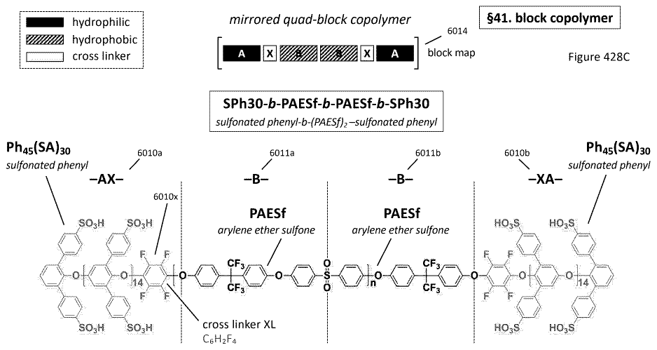

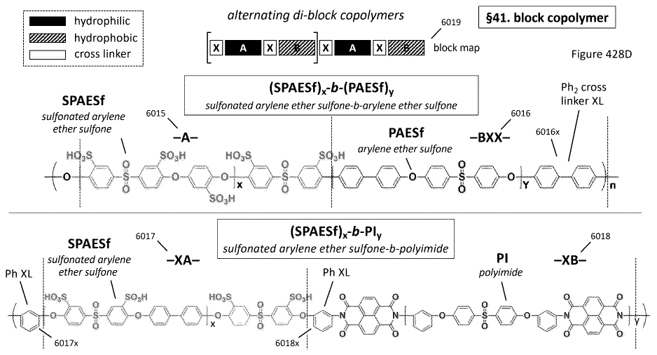

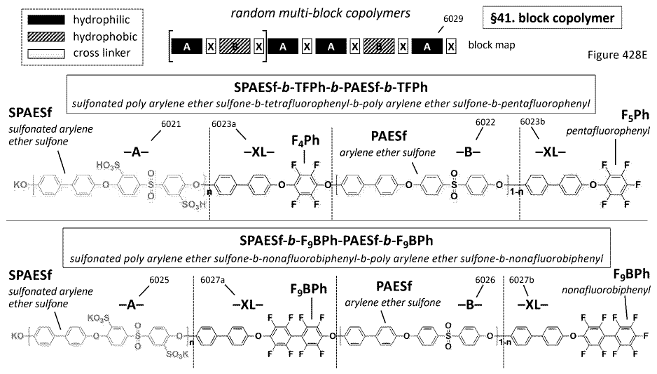

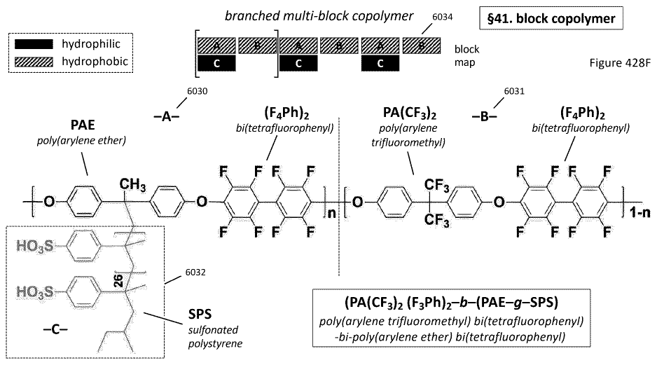

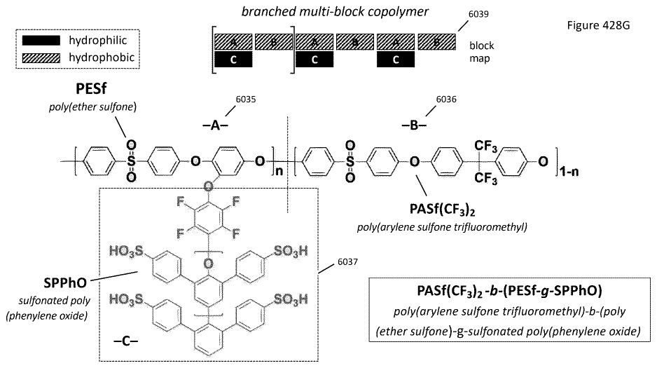

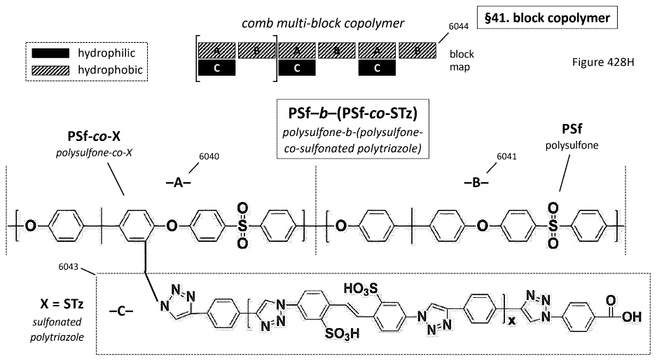

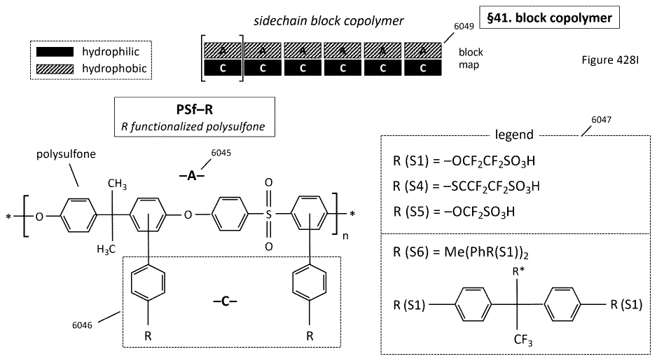

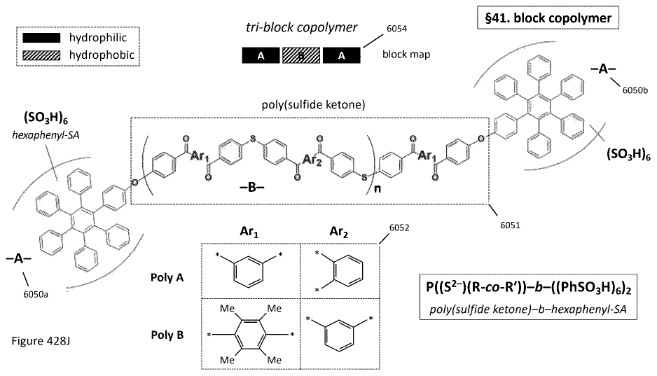

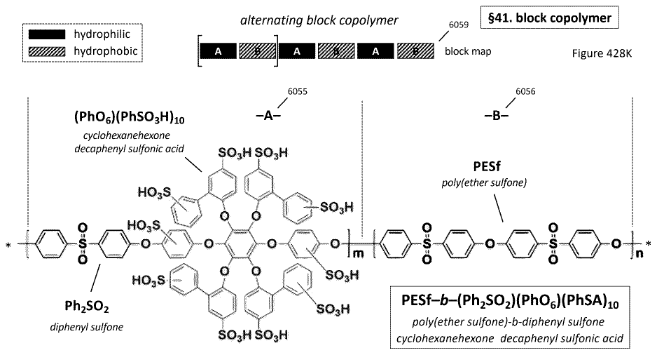

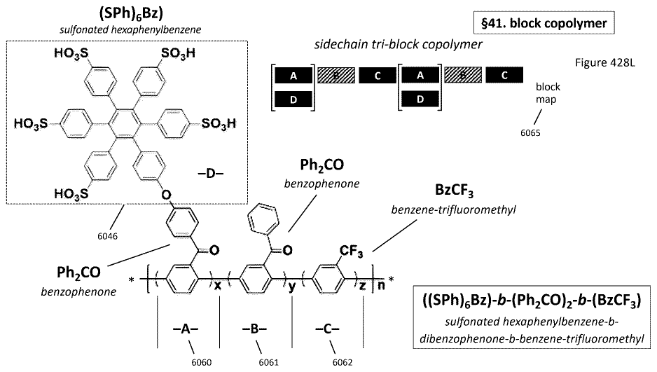

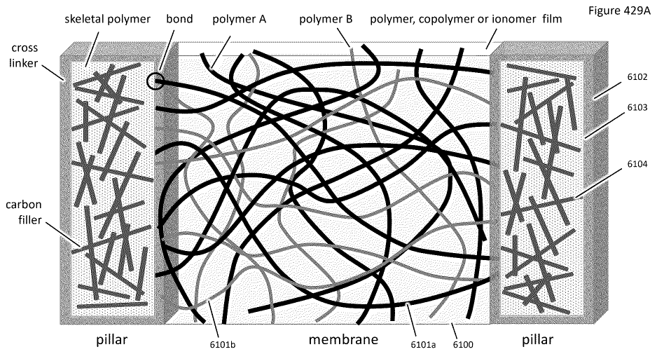

FIG. 428A illustrates a penta-block copolymer 6004 referred to as (t-BuS)-b-(Eth-co-Prp)-b-(PSS-co-PS)-b-(Eth-co-Prp)-(t-BuS) where PS 6002b and PSS 6002a refer to un-sulfonated and sulfonated polystyrene; BuS refers to a tert-butyl styrene 6000a and 6000b; and Eth-co-Prp 6002a and 6002b refer to a hetero-copolymer of ethanol and propanol. In polymer nomenclature -b- refers to a block designator while -co- refers to a copolymer within a block. As a penta-block copolymer 6004, the sequence comprises three types of copolymers repeating sequentially in blocks of five in the sequence -(A-B—C—B-A)-. Only the sulfonated poly styrene segment PSS 6002a within block C containing the SO₃H ionomer is hydrophilic, and remaining blocks are hydrophobic.

FIG. 428B illustrates a quad-block copolymer 6009 referred to as PSS-b-Et-b-(Eth-ran-Prp)-(PSS) where PSS 6005a and 6005b refer to sulfonated polystyrene; where unlabeled segment 6006 refers to an ethyl group forming the polystyrene backbone; and where Eth-ran-Prp 6007 refers to a randomly occurring copolymer blend of ethanol and propanol. As a quad-block copolymer 6009, the sequence comprises three types of copolymers repeating blocks of four having the sequence -(A-B-C-A)-. The PSS sulfonated styrene segments comprising block A is hydrophilic, while blocks B and C are hydrophobic.

FIG. 428C illustrates mirrored quad-block copolymer 6014 referred to as SPh30-b-PAESf-b-PAESf-b-SPh30 where SPh30 forms the hybrid blocks AX 6010A and XA 6010B containing 15 groups of sulfonated triphenyls Ph₃ along with 1,2,4,5-tetrafluorobenzene (C₆H₂F₄) 6010x as a cross linker to two blocks of poly arylene ethyl sulfone (PAESf, PAES) 6011a and 6011b. The term SPh30 is shorthand for phenyl sulfonic acid comprising Ph₄s(SA)₃₀. To be more consistent with the nomenclature of this application, a less ambiguous abbreviation for this molecule is PAESf. Although block map 6014 illustrates the cross linker X as a separate block, it is actually integrated into block A and thereby labelled AX 6010A or its mirror isomer XA 6010B. In aggregate, the mirrored quad-block copolymer 6014 has a sequence (AX)BB(XA).

FIG. 428D illustrates two examples of alternating di-block copolymers 6019 comprising the repeated sequence ABXX, i.e. ABXXABXX . . . or alternatively XAXB, i.e. XAXBXAXB . . . In the topmost example (SPAES)ₓ-b-(PAES)_{y} or using the more precise naming (SPAESf)ₓ-b-(PAESf)_{y}, the di-block copolymer comprises alternating blocks A 6015 of sulfonated poly arylene ethyl sulfone (SPAESf) of block length x and block BXX 6016 comprising un-sulfonated poly arylene ethyl sulfone (PAESf) of block length y. Typical chain lengths may comprise x=y=10. Increasing the length of the hydrophilic block A over that of hydrophobic block B, i.e. where x>y, increases the film's conductivity but decreases film strength and cycle life. Made in accordance with this invention, by forming this membrane into the previously described endoskeletal matrix largely ameliorates the affect of block length on the IEM's mechanical strength and cycle life. Block BXX comprises the PAESf polymer bound to two phenyl groups Ph₂ serving as cross linkers 6015x, one to block B, the second bond to block A of the next block pair.

Another alternating di-block copolymer 6019 shown in the lower chemical representation of FIG. 427D, block copolymer (SPAESf)ₓ-b-(PI)_{y} comprise block XA 6017 where polymer ‘A’ comprises sulfonated poly arylene ethyl sulfone (SPAESf) of block length x and where X comprises a single phenyl cross-linker 6017x; block XB 6018 where block B comprises polyimide (PI) and X comprises a single phenyl cross-linker 6018x.

FIG. 428E contrasts two multi-block copolymers 6029 comprising random sequences of hydrophilic blocks A and hydrophobic blocks B separated by cross linkers X as chain extenders. As sequences such as AXBXAXAXBXAX . . . shown are random, a simple exemplary representation of an alternating sequence AXBX is adequate to depict this class of blockchains.

In the top graphic illustrating block copolymer SPAESf-HFB-PAESf-HFB, hydrophilic block A 6021 comprises sulfonated arylene ether sulfone (SPAESf) forming a block copolymer with hydrophobic block B 6022 comprising un-sulfonated arylene ether sulfone (PAESf). The two blocks are bound through cross linkers XL 6023a and 6023b comprising hexafluorobenzene (HFB).

In the lower graphic illustrating block copolymer SPAESf-DFBP-PAESf-DFBP, hydrophilic block A 6025 comprises sulfonated arylene ether sulfone (SPAESf) forming a block copolymer with hydrophobic block B 6026 comprising un-sulfonated arylene ether sulfone (PAESf). The two blocks are bound through cross linkers XL 6027a and 6027b comprising hexafluorobenzene decafluorobiphenyl (DFBP).

FIG. 428F illustrates a branched block copolymer PAE-b-(PAE-g-SPS) 6034 comprising a partially-fluorinated hydrophobic poly(arylene ether) mainchain including a nascent segment B 6031 and grafted segment A 6030 with oligomeric sulfonated polystyrene (SPS) as flexible hydrophilic sidechain C 6032.

FIG. 428G illustrates PAESf-b-(PAESf-g-SPPhO), a branched block copolymer 6039 comprising an alternating ABAB hydrophobic backbone of nascent poly(arylene ether sulfone) (PAESf) block B 6036 and a poly(ether sulfone) PESf block A 6035 grafted to sidechain block C 6037 comprising sulfonated poly(phenylene oxide) (SPPhO).

FIG. 428H illustrates PSf-b-(PSf-co-STz), a branched comb-structure block copolymer 6044 comprising an alternating ABAB hydrophobic backbone of nascent polysulfone (PSf) block B and PSf block A 6040 forming a copolymer with sidechain block C 6043 comprising sulfonated polytriazole (STz).

FIG. 428I illustrates a sidechain block copolymer 6049 with a hydrophilic backbone of block A 6045 comprising polysulfone PSf with sidechain blocks C 6046 comprising a phenyl group with radical R. As illustrated in legend 6047, the radical R may comprise a variety of functional groups with sulfonic acid termini including R(S1)=—(OCF₂)CF₂(SO₃H); R(S4)=—(SCCF₂)CF₂(SO₃H); R(S5)=—OCF₂(SO₃H); and a biphenyl compound R(S6)=Me(PhR(S1))₂.

Other densely sulfonated block copolymers include sulfonic acid groups locally concentrated in specific regions of the molecular moieties with well-defined phase-separated structures inducing comparable or better proton conductivity than PFSA-based ionomers.

In FIG. 428J, the tri-block copolymer 6054 poly(sulfide ketone)-b-hexaphenyl-SA comprises a poly(sulfide ketone) hydrophobic backbone of block B 6051 of composition P((S²⁻)(RCOR′)). The poly(sulfide ketone) group forms a block polymer with two hydrophilic hexaphenyl block A groups 6050a and 6050b of composition (PhSO₃H)₆ including six phenyl groups and six sulfonic acid groups (SA). The backbone includes two functional groups Ar₁ and Ar₂ as described in table 6052.

FIG. 428K illustrates a linear alternating block copolymer PESf-b-(PhSA)₁₀ 6059 comprising hydrophobic block B 6056 and hydrophilic block A 6055 comprising decaphenyl sulfonic acid (PhO₆)(PhSO₃H)₁₀.

FIG. 428L illustrates highly sulfonated polyphenyl pendant groups abbreviated SPPFPB 6055 comprising three phenyl blocks A 6060, B 6061, and C 6062 with a sidechain block D 6046 comprising hexaphenyl group Ph(PhSA)₆. One possible name of the block polymer is sulfonated hexaphenylbenzene-b-dibenzophenone-b-benzene-trifluoromethyl ((SPh)₆Bz)-b-(Ph₂CO)₂-b-(BzCF₃) or more accurately by its triblock polymer nomenclature (hexaphenylbenzene-co-benzophenone)-b-(benzophenone)-b-(benzene-trifluoromethyl) (((SPh)₆Bz)-co-(Ph₂CO))-b-(Ph₂CO)-b-(BzCF₃).

Any of the aforementioned block copolymers can be combined with the previously described endoskeletal support, the sacrificial filler micropores, or a combination thereof.

### Summary of Ion Exchange Membranes.

The ion exchange membranes described herein comprise a variety of novel fabrication sequences resulting in unique structural matrices of polymers and ionomers overcoming the inherent deficiencies of fragility, inconsistency, poor conductivity, and limited longevity plaguing present day ion exchange membranes. Structural features unique to ionomeric membranes and solid electrolytes made in accordance with this invention include an combination of:
endoskeletal support pillars or grid providing mechanical support to an ionomeric or polymeric matrix or ion exchange membrane including necessary bonding between the thin polymer matrix and the skeletal support grid;
a homopolymer comprising two-or-more hetero-ionomers forming a proton exchange membrane (PEM) or an anion exchange membrane (AEM) providing superior conductance over a wide range of operating conditions;
various combinations of two-or-more copolymers integrating a homo-ionomer into an electrolyte film with controlled pore size and pore density offering good conductivity with limited fuel crossover in a proton exchange membrane (PEM) or an anion exchange membrane (AEM);
an ionomeric membrane or film comprising two-or-more hetero-ionomers integrated into a homopolymer or into two-or-more copolymers forming a proton exchange membrane (PEM) or an anion exchange membrane (AEM) providing superior conductance over a wide range of operating conditions;
an ionomeric membrane containing ‘sac pores' comprising voids of controlled size and density created using a sacrificial filler process described herein;
an ionomeric membrane containing the aforementioned sac pores doped with permanent fillers affecting conductivity and material properties;
an ionomeric membrane containing the aforementioned sac pores doped with an ionic liquid
an ionomeric membrane doped with an ionic liquid who leakage is limited by the presence of an inert nonporous endoskeletal matrix.
a nanocoating applied to the planar surfaces of an ion exchange membrane controlling catalytic activity, limiting leakage of ion liquids, and/or preventing environmental contamination of the membrane with carbon monoxide and other chemicals toxic to the membrane, its ionomers, or its catalysts.

The foregoing inventive polymer and ionomer features may be used separately or in combination, for example (i) endoskeleton only, (ii) sacrificial filler only, (iii) endoskeleton and sacrificial filler, (iv) permanent fillers and dopants, (v) endoskeleton with permanent fillers and dopants, (vi) sacrificial filler combined with permanent fillers and dopants, (vii) endoskeleton with sacrificial filler combined with permanent fillers and dopants, and (viii) any of the foregoing with nanocoatings applied to the membrane surfaces.

### Ionomeric Polymers.

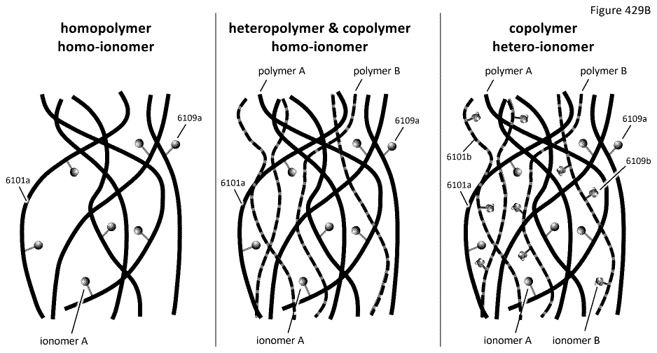

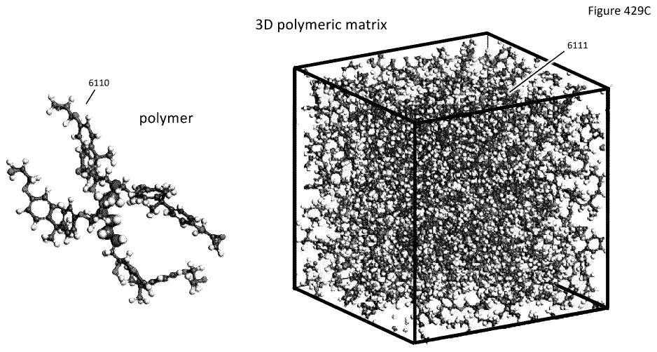

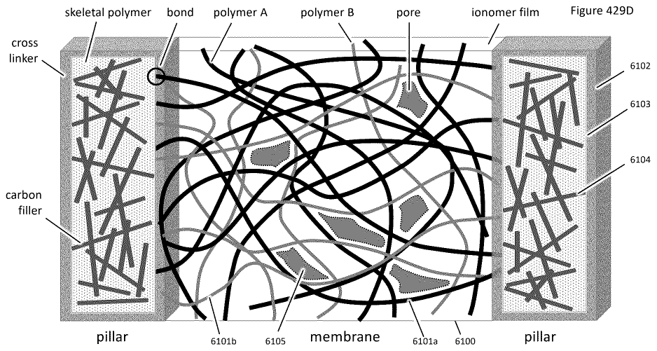

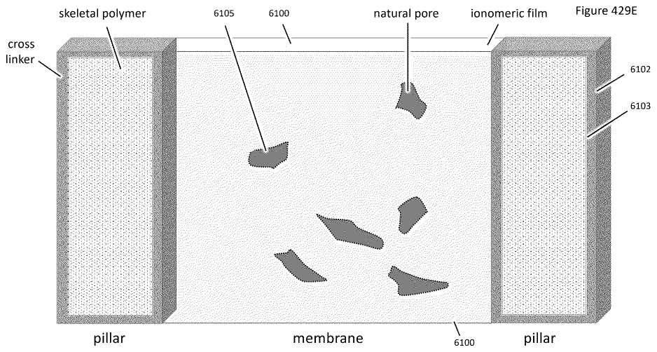

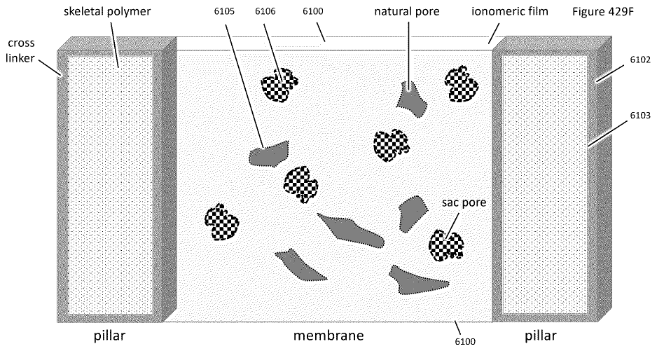

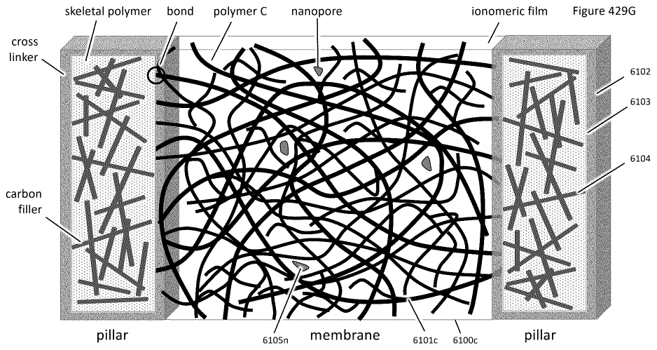

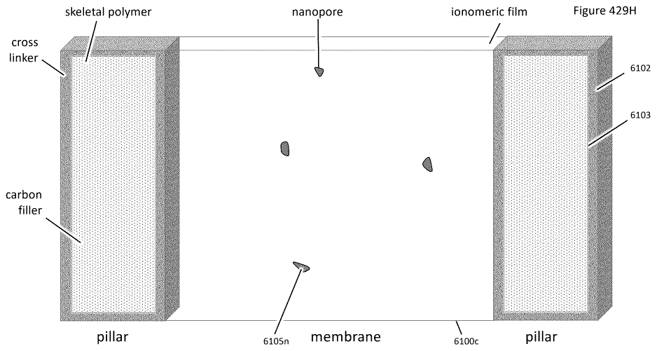

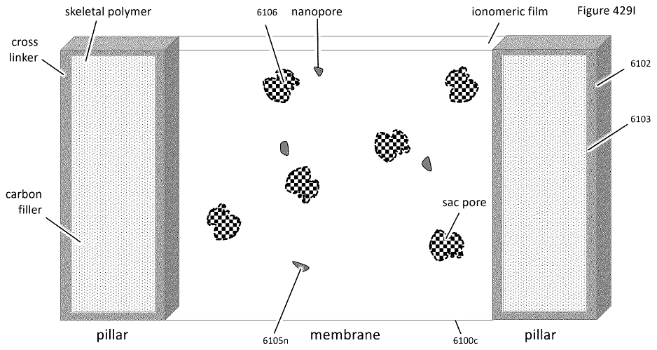

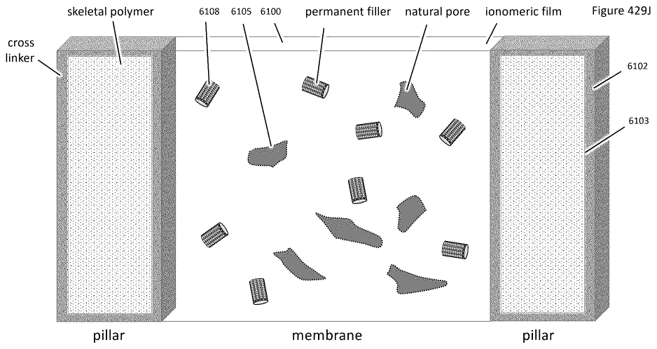

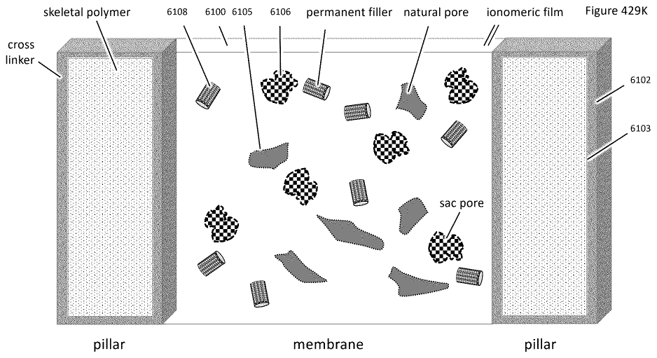

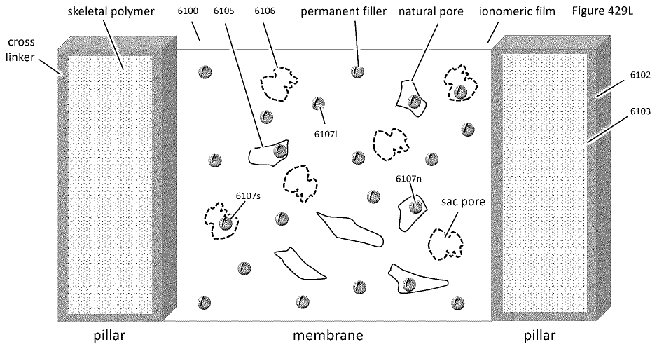

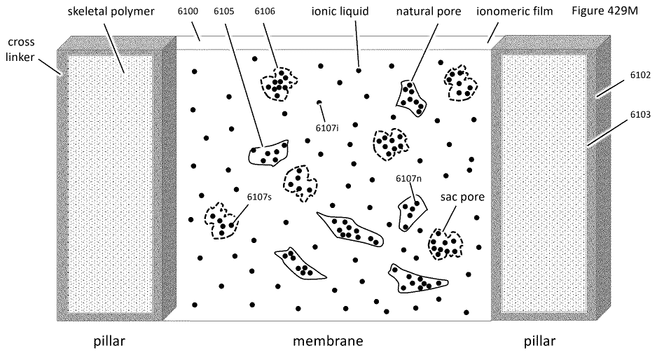

These features are illustrated in summary form in the illustrations comprising FIG. 429A through FIG. 429M. Specifically FIG. 429A depicts a quasi 3D representation of a polymer or ionomeric film 6100 comprising two copolymers, polymer A 6101A and polymer B 6101B bound by endoskeletal polymer pillars 6103 optionally strengthened by carbon filler 6104 or other reinforcing materials. As shown, one or both copolymers forming polymer or ionomeric film 6100 may bond to the pillars forming the endoskeletal support either directly or assisted by a cross linker, adhesive, or molecular glue depicted as coating 6102. Although this cross linker is represented as a unform coating exterior to the pillar's polymeric matrix, it may also permeate into the polymer forming links or grafts between the ionomer's backbones polymer A 6101A and/or polymer B 6101B and the endoskeletal polymer. Cross linkers are especially important when the polymer chains are chemically inert and hydrophobic.

In another embodiment of this invention, an ion exchange membrane may contain one or more types of ionomers. FIG. 429B provides a schematic representation of various homopolymers heteropolymers, and copolymers and their ionomers. In most cases, the electrically conductive or catalytically active ionomer forms the chemical terminus of a sidechain or pendant attached to the main backbone or spine of the polymer. For example, the homopolymer exemplified by the left side graphic comprises polymer 6101a with attached pendants terminating in homo-ionomer 6101a. This type of IEM is referred to herein as a homopolymer homo-ionomer as it comprises identical monomers used to form the polymer. Unfortunately, such homopolymers often suffer from an inverse relationship between conductivity and structural integrity where the thinnest and most porous films exhibit the least durability, and shortest use life.

If the ionomer concentration comprises too high of mole fraction of the polymeric membrane excessive water retention, membrane swelling, humidity dependence, and humidity cycling induced reliability failures can result. The ionomer concentration can be limited either by either employing longer monomers or by dividing the polymer into two segments, those with ionomeric pendants and those without. By controlling their respective lengths, the mole fraction of the ionomer is determined. A ‘di-monomer’ chain therefore comprises a homogenous polymer backbone having alternating segments of repeated two monomers distinguishable only by those segments with attached pendants and ionomeric termini, the ratio of which determines the compromise between strength and conductance.

Since the two monomers differ only by being inert or functionalized, the polymer can be considered as a heteropolymer. Alternatively because the backbone itself is essentially the same in every segment, the polymer can also be considered as a homopolymer, or more precisely as a hybrid homopolymer. Regardless, the ion exchange film comprises a homo-ionomer as it contains only a single species of ionomer as a functional group. Such di-monomer membranes may include both fluorocarbons, hydrocarbons, or a blend of both.

The di-monomer comprising the composite reinforced membrane (CRM) of PFSA-PTFE is exemplary as the non-pendant segments of the TFE backbone of PFSA differs from inert PTFE only in length, not in composition. As such, the longer the hydrophobic portion of the chain is extended, the stronger the membrane becomes and the lower its conductivity. Furthermore because of its hydrophobicity, expanded lengths of PTFE chains also form quasi-crystalline domains within the membrane reducing film porosity thereby inhibiting vehicular transport of hydronium and further degrading membrane conductance.

Another broad class of ion exchange membranes comprise heteropolymer and copolymer films. As shown in the center graphic of FIG. 429B, these polymers are formed by two different polymers—polymer A 6101a with an associated pendant and ionomer A 6109a terminus, and a second polymer B 6101b having no ionomeric group. The same results occur when two distinct copolymers are blended together. For example the addition of polypropylene (PP) to PFSA as shown previously in FIG. 125, strengthens the membrane but reduces conductivity.

To compensate for degraded conductivity in heteropolymers and copolymers, ion exchange membranes made in accordance with this invention involve methods to (i) control the porosity of the film to enhance proton transport, (ii) enhance the carrier density through the addition of permanent fillers and dopants, (iii) enhancing proton generation and oxygen reduction rates at the catalyst-layer-to-membrane interface, and (iv) enhancing gas flow to the CCM through graded or multilayer gas diffusion layers.

To control the film porosity as per item (i), the membrane composition is adjusted to reduce crystallinity to prevent dense compaction of the polymer strands by the application of a sacrificial filler to form sac pores in the polymer matrix. To enhance proton transport vis-h-vis item (ii) within the ionomer, a variety of permanent fillers made in accordance with this invention such as functionalized carbon nanotubes (CNTs), graphene oxides (GOs), and metal organic frameworks (MOFs) are introduced into the mold compound prior to polymerization. Some larger permanent fillers described herein also can enhance film porosity. Alternatively or in combination, ionic liquids can be introduced into the membrane post polymerization.

For item (iii), improved ion transport at the catalyst-membrane interface is achieved by either etching the interface using sputter etching prior to CL deposition, or by applying a nanoparticle coating after polymerization but prior to CL formation. A heterogenous slurry of carbon and catalyst metal optionally combined with catalytic PMMA nanoparticles or MOFs can also be used to enhance ionization rates, especially in the cathode interface controlling the oxygen reduction rate (ORR). In one embodiment, the catalyst layer composition on the anode and cathode are dissimilar, with the cathode containing alternative metals such as tungsten, palladium, and titanium dioxide along with barriers against carbon monoxide such as boron-nitride nanoparticles. For item (iv), the gas diffusion layer is deposited or printed atop a denser carbon substrate with monotonically declining density either layered or continuously varying porosity.

In the rightmost graphic of FIG. 429B, a hetero-ionomer copolymer comprises two different polymers 6101a and 6101b with two different ionomer groups 6109a and 6109b respectively. Examples include the combination of sulfonic and phosphonic acid which nominally operate at different temperatures. Combining them together into a common IEM expands the operating temperature range of the membrane without causing excess hydration and swelling, especially when combined with the inventive endoskeletal support matrix described herein.

### Polymer Porosity.

As described above, the porosity of an ionomeric membrane made in accordance with this invention is a function of the packing density of the polymer strands constituting the membrane. For example, as depicted in the graphic of FIG. 429C, polymer strands 6110 combine together to form a dense matrix 6111 of interwoven polymer backbones, forming a spiderweb type matrix with virtually no uniformity in density or directionality of strands forming the matrix. When the strands are loosely packed, the polymeric membrane may be considered structurally as amorphous or quasi-amorphous. Should the polymers pack together more densely in a crystalline-like manner, the matrix may be considered as ‘quasi;-crystalline.’ Except in rare experimental cases where magnetic fields are employed to align strings of atoms during synthesis, such polymers are never truly crystalline like semiconductor materials such as silicon, gallium arsenide, gallium nitride, or semiconducting diamond.

That said, the atomic packing density and inversely, the membrane's porosity are both measures of a polymer's degree of crystallinity or lack thereof. The impact of atomic structural property affecting porosity is depicted phenomenologically in the schematic representation of a skeletally reinforced polymeric membrane shown in FIG. 429D. As shown in a planar 2D cross section, a polymeric matrix such as an ionomeric film 6100 is formed between endoskeletal pillars circumscribing the membrane. The endoskeletal pillars comprise pillar polymer 6103 contain strengthening fillers 6104 of carbon fiber, polymer shards, or other reinforcers. Pillar polymer 6103 is optionally coated by an adhesive or cross linker facilitating chemical bonding and attachment of the polymer A 6101a, polymer B 6101b, or both.

Interstitially located with and among the random distribution of polymer strands, are naturally-occurring pores 6105 the size and shape of which is determined by the density of the polymer strands polymer A 6101a and polymer B 6101b. The closer and more tightly-packed these polymeric strands are, the smaller the average size of pore 6105 is. The more loosely the polymer backbones are packed, the larger the pores become. FIG. 429E illustrates the same matrix without showing the fibrous polymer strands of the pillar fillers. It should be noted that the density is not so great if only pores connected through tunnels to form channels to other pores are considered. An isolated pore is unable to participate in proton conduction and are therefore not included.

FIG. 429F illustrates the pore density can be increased over the naturally occurring pore density using the sacrificial filler process. In this process, a temporary filler is introduced into the mold compound prior to polymerization. After polymerization the filler is removed by a solvent from polymer matrix leaving holes called ‘sac pores’ 6106 in the membrane. The size and density of the sac pores 6106 in ionomeric film 6100 is controllable by the concentration and size of the filler material added to the mold compound prior to polymerization. It should be noted that depending on the degree of crystallinity of ionomeric film 6100, the beneficial impact of sac-pores 6106 on ionomeric conductivity can vary significantly.

For contrast, FIG. 429G illustrates a much higher density quasi-crystalline polymer C 6101c resulting in a significant reduction is the size and density of the interstitial naturally-occurring pores in the polymeric matrix 6100c, illustrated graphically by nanopore 6105n. FIG. 429H illustrates the same nanopores 6105n without showing strands of fibers or polymers. Comparison to the naturally occurring pores 6105 of FIG. 429E, the occurrence of nanopores 6105n is less dense and substantially smaller. Moreover, the total area of the naturally occurring nanopores is sufficiently small to render quasi-crystalline polymer membranes useless as ion exchange membranes. The inclusion of sacrificial pores 6106 into semicrystalline ionomeric film 5100c shown in FIG. 429I dwarfs the limited proton channels of naturally occurring nanopores 6105n, meaning the net conductivity of the membrane is almost entirely determined by the impact of the sacrificial filler process.

Another means by which to modulate the conductivity of an ionomeric membrane is shown in FIG. 429J where permanent fillers 6108 are included in the mold compound prior to molding of ionomeric film 6100. After polymerization, the membrane includes both naturally-occurring interstitial pores 6105 and permanent fillers 6108. In FIG. 429K ionomeric film is modified to include sac pores 6106 formed using a sacrificial filler process. In both illustrations the size of permanent fillers 6108 exceed the size of naturally-occurring interstitial pores 6105 and sac pores 6106. In an alternative version shown in FIG. 429L the permanent fillers are smaller than the dimensions of the voids and pores contained in ionomeric film 6100. The smaller permanent fillers include permanent fillers 6107i located interstitially within the polymer matrix, permanent fillers 6107n pooling within the naturally-occurring pores 6105, and permanent fillers 6107s pooling within sac pores 6106.

FIG. 429M illustrates an ionomeric film 6100 doped with ionic liquid molecules 6107i present in the polymer's interstitial matrix, ionic liquid molecules 6107n pooling within the membrane's naturally occurring pores 6105, and ionic liquid molecules 6107s pooling within sac pores 6106.

### Polymer Chemistries.

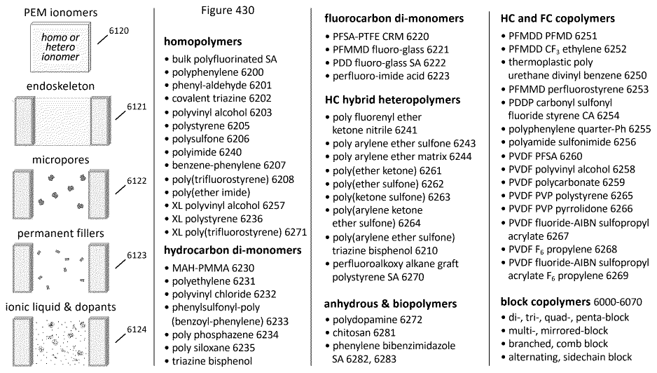

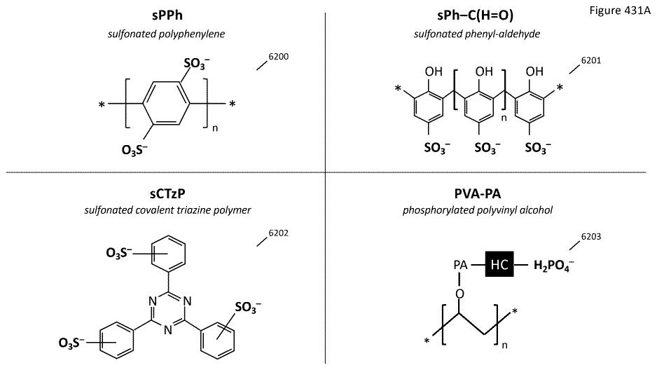

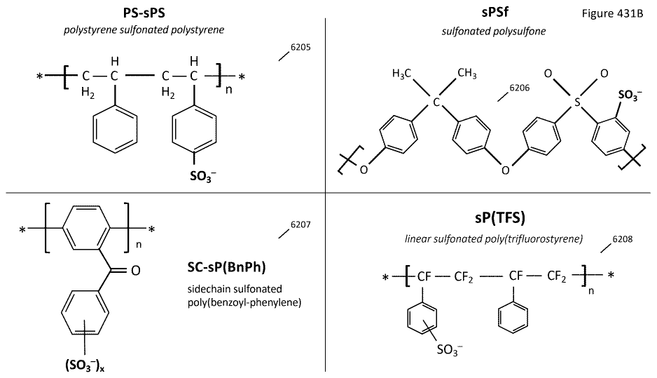

Various constructions of IEMs along with exemplary polymers are listed in FIG. 430. As shown, options include homo-polymers or hetero-polymers PEM ionomer lacking any endoskeleton. Other options include PEM ionomer 6620 combined with endoskeleton 6121, PEM ionomer 6620 combined with endoskeleton and micropores 6122, PEM ionomer 6620 combined with endoskeleton with permanent fillers 6123, and/or ionic liquids with membrane pores 6124. Ionomeric membranes listed include those comprising homopolymers, fluorocarbon di-monomers, hydrocarbon di-monomers, hydrocarbon multi-polymers, hydrocarbon and fluorocarbon copolymers, hydrocarbon hybrid heteropolymers, anhydrous polymers and biopolymers, and block polymers.

Abbreviations used in FIG. 430 include SA for sulphonic acid; MAH for maleic anhydride polyolefins; PMMA for poly(methyl methacrylate); XL for cross linker; PFSA for perfluorinated sulfonic acid; PTFE for polytetrafluorethylene; PFMDD for perfluoro-methylene-methyl-dioxolane; fluoro-glass to mean fluorinated glassy compounds such as PFMDD and perfluoro imide acid (PFIA); PVDF for polyvinyldifluoride; PVP for polyvinylpyrrolidone; AIBN for azobisisobutyronitrile; F₆ for hexafluoride; PDDP for para-dodecylphenol; and CA for cellulose acetate.

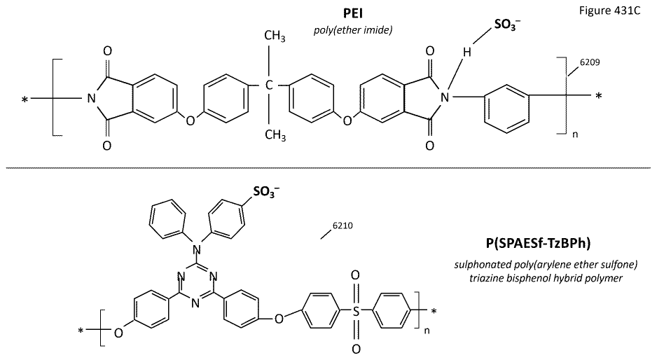

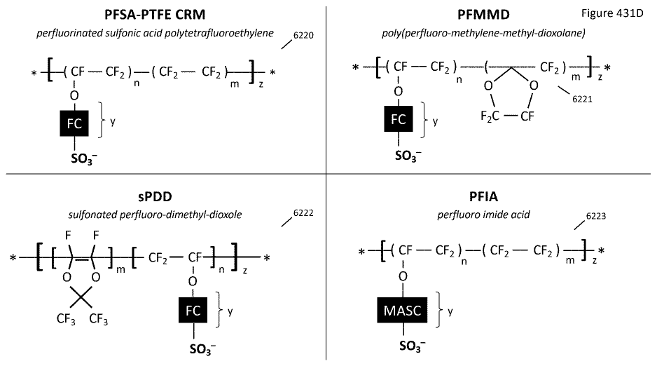

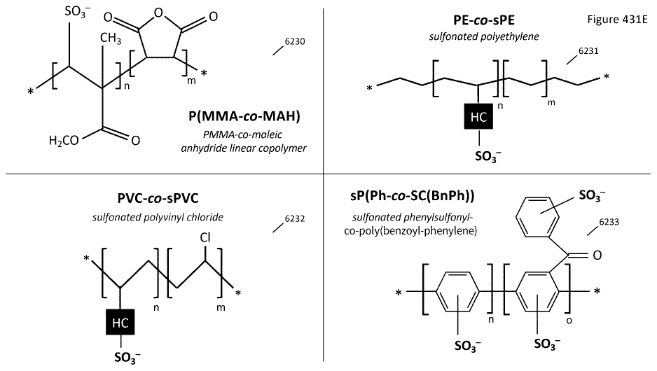

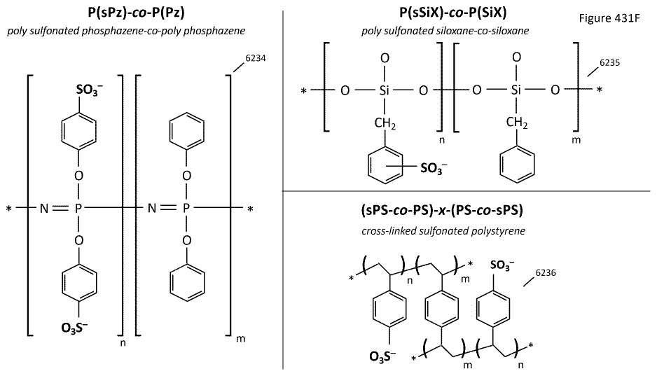

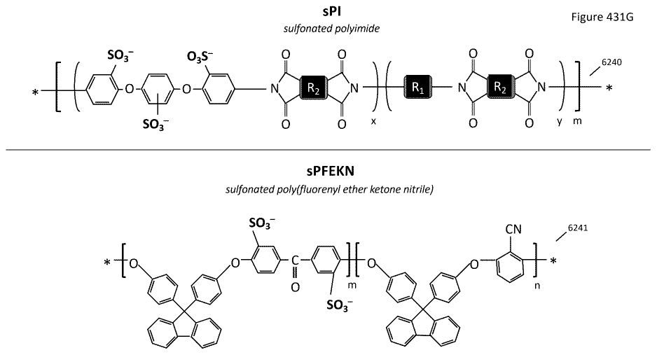

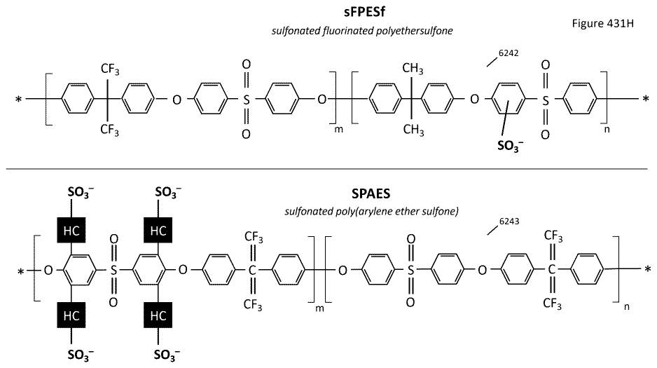

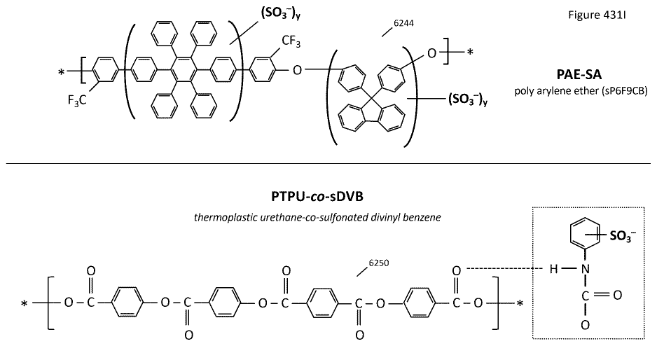

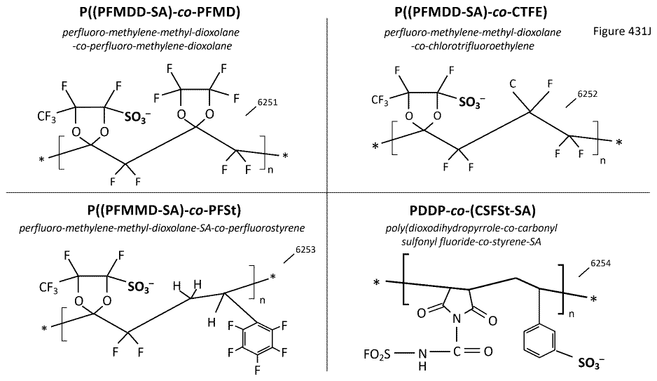

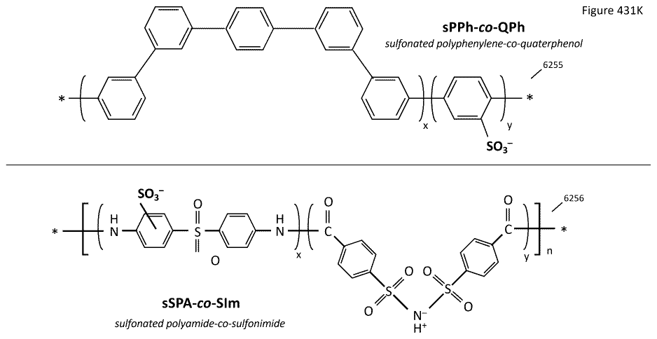

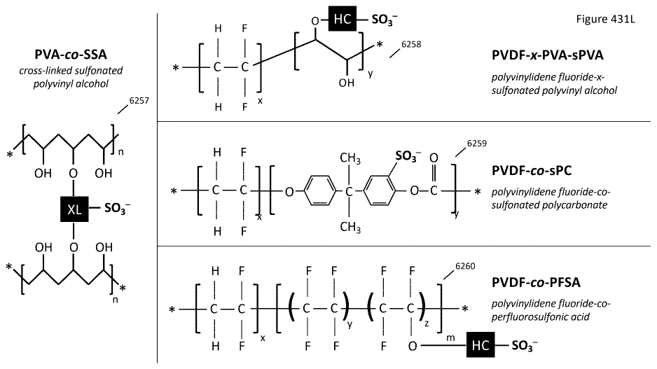

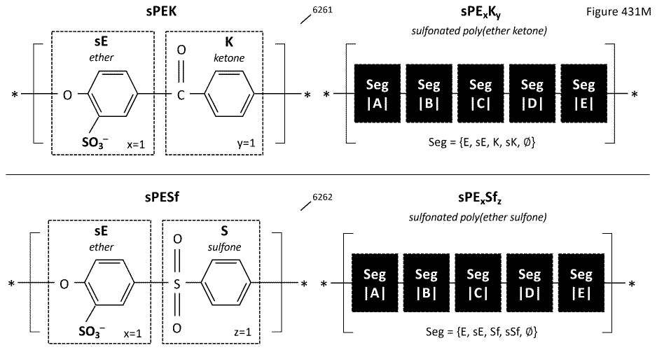

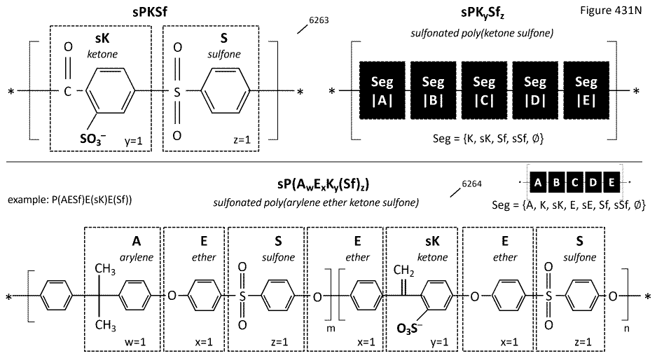

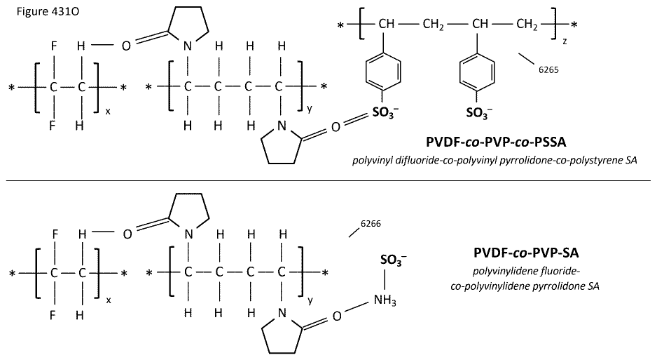

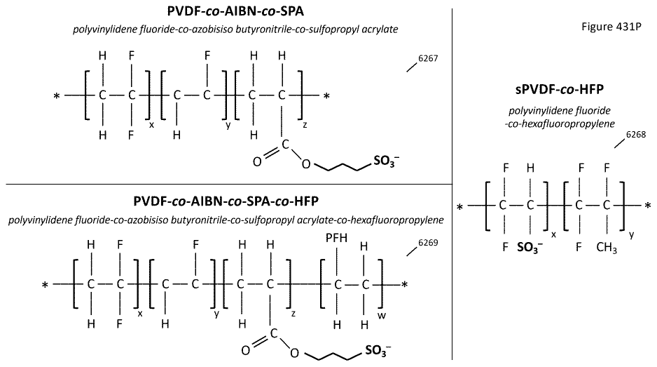

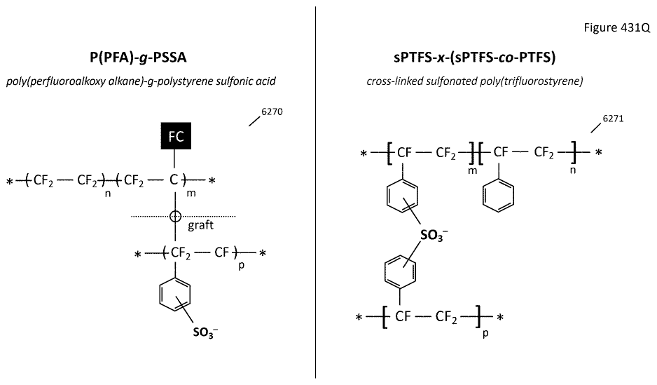

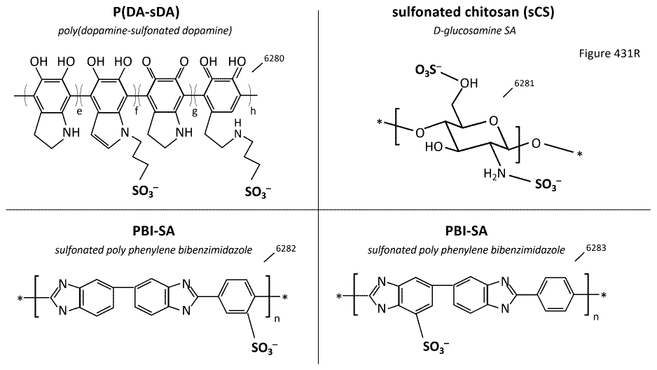

Examples of hydrocarbon homopolymers shown in FIG. 431A include sulfonated polyphenylene (sPPh) 6200, sulfonated phenyl-aldehyde (sPh-C(H═O)) 6201, and sulfonated covalent triazine polymer (sCTzP) 6202, all depicted with a sulfonic acid (SO₃) ionomer. Other acids such as phosphonic acid may be substituted for the sulfonic acid as shown by phosphorylated polyvinyl alcohol (PVA-PA) 6203. The ionomeric membranes as fabricated herein may contain a combination of hetero-ionomers, copolymers, micropores, permanent fillers, ionic liquids, and/or ionomeric dopants.

Other homopolymers as shown in FIG. 431B include polystyrene sulfonated polystyrene (PS-sPS) 6205, sulfonated polysulfone (sPSf) 6206, sidechain sulfonated poly(benzoyl-phenylene) (SC-sP(BnPh)) 6207, and linear sulfonated poly(trifluorostyrene) (sP(TFS)). In the example shown a sulfonic acid (SO₃) ionomer is attached to a phenyl group, where the phenyl groups may be located on-chain, i.e. an ionone, or may form a sidechain of a pendant group. Other acids such as phosphonic acid may be substituted for the sulfonic acid. The ionomeric membranes as fabricated herein may contain a combination of hetero-ionomers, copolymers, micropores, permanent fillers, ionic liquids, and/or ionomeric dopants.

FIG. 431C illustrates longer monomer based hydrocarbon membranes of poly(ether imide) (PEI) 6209 and sulphonated poly(arylene ether sulfone) triazine bisphenol hybrid polymer P(SPAESf-TzBPh) 6210. To limit the maximum concentration of ionomers present in a film to prevent swelling and over hydration, the polymer may comprise longer monomer lengths, utilize longer side chains, or include fewer acid groups within the repeated segment. Extremely short monomers such as sPPh 6200 and sPh-C(H═O) 6201 are often combined with non-sulfonated segments of the same chemistry forming a hybrid polymer of di-monomers.

As depicted, the ionomer may constitute a sulfonic acid group of SO₃⁻ or may be substituted by other acids such as phosphonic or phosphotungstic acid. The ionomeric membranes as fabricated herein may contain a combination of hetero-ionomers, copolymers, micropores, permanent fillers, ionic liquids, and/or ionomeric dopants.

Di-monomer ion exchange membranes made in accordance with this invention comprise two classes of polymers—fluorocarbons and hydrocarbons. Because the polymer backbone is essentially identical for the two segments except that one attaches to a pendant and the other doesn't then such polymers may be referred to as a hybrid polymer but generally not as a copolymer. Whether they are referred to as heteropolymers is a matter of opinion as the spine of the polymer is essentially unaltered but the segment is in fact different because of its attached sidechain and ionomer terminus.

Several fluorocarbon di-monomer membranes are illustrated in FIG. 431D. They include the well known composite reinforced membrane (CRM) of perfluorinated sulfonic acid polytetrafluoroethylene (PFSA-PTFE) 5220 including an inert hydrophobic Teflon-like segment of length ‘m’ and a hydrophilic TFE segment of length ‘n’ attached to a fluorocarbon sidechain with a sulfonic acid (SO₃) terminus. Other acids such as phosphonic acid may be substituted for the sulfonic acid. In cases where the length ‘m’ of the hydrophobic segment is sufficiently short, the resulting ionomeric polymer may be considered as the homopolymer PFSA rather than a PFSA-PTFE CRM. In cases where the length ‘y’ of the fluorocarbon sidechain is short and the membrane is thin, the IEM behaves as a bulk conductor with a blend of proton charge hopping and vehicular transport of hydronium ions. Conversely for long-chain thicker layers, conduction occurs primarily along the polymer spines via charge hopping, constrained charge transport similar to surface conduction.

Other di-monomer fluorocarbon membranes with sulfonic acid ionomers include glassy matrices of poly(perfluoro-methylene-methyl-dioxolane) (PFMMD) 6221 and perfluoro-dimethyl-dioxole (PDD) 6222. A related polymer with the same TFE-PTFE polymer backbone is perfluoro imide acid (PFIA) 6223, where the fluorocarbon sidechain is replaced by an MASC, a multi-acid side chain of length ‘y’. The ionomeric membranes as fabricated herein may contain a combination of hetero-ionomers, copolymers, micropores, permanent fillers, ionic liquids, and/or ionomeric dopants.

As shown in FIG. 431E, hydrocarbon di-monomer membranes made in accordance with this invention include poly(methyl methacrylate)-co-maleic anhydride (PMMA-co-MAH) linear copolymer 6230; sulfonated polyethylene linear copolymer (PE-co-sPE) 6231; and sulfonated polyvinyl chloride linear copolymer (PVC-co-sPVC) 6232, all of which include two segments, one of length ‘n’ including an ionomer of sulfonic acid SO₃⁻ and another segment of length ‘m’ lacking any ionomer. A fourth copolymer sulfonated (phenylsulfonyl-co-poly(benzoyl-phenylene)) (sP(Ph-co-SC(BnPh))) 6233 is shown with two segments of lengths ‘n’ and ‘o’, each with sulfonic acid SO₃⁻.

In the segment of length ‘n’ the ionomer is attached to the mainchain as an ionone, while in the other segment the ionomer is attached to a sidechain. As depicted, the ionomers may constitute a sulfonic acid group of SO₃ or may be substituted by other acids such as phosphonic acid. The ionomeric membranes as fabricated herein may contain a combination of hetero-ionomers, copolymers, micropores, permanent fillers, ionic liquids, and/or ionomeric dopants.

Made in accordance with this invention, hydrocarbon di-monomer copolymers shown in FIG. 431F include poly sulfonated phosphazene-co-poly phosphazene P(sPz)-co-P(Pz) 6234; poly sulfonated siloxane-co-siloxane P(sSiX)-co-P(SiX) 6235; and cross-linked sulfonated polystyrene (sPS-co-PS)-x-(PS-co-sPS) 6236. all of which are depicted to include segments of length ‘n’ attached to SO₃ ionomers and segments of length ‘m’ lacking any conductive groups. The sulfonic ionomer may however be substituted by other acids such as phosphonic acid. The ionomeric membranes as fabricated herein may contain a combination of hetero-ionomers, copolymers, micropores, permanent fillers, ionic liquids, and/or ionomeric dopants.

Other highly asymmetric di-monomer copolymers include sulfonated polyimide (sPI) 6240 and sulfonated poly(fluorenyl ether ketone nitrile) (sPFEKN) 6241 in FIG. 431G, along with sulfonated fluorinated polyethersulfone (sFPESf) 6242 and sulfonated poly(arylene ether sulfone) (SPAES) 6243 shown in FIG. 431H and poly arylene ether (PAE-SA, sP6F9CB) 6244 shown in FIG. 431I. Although the ionomers shown may constitute sulfonic acid groups of SO₃ or may be substituted by other acids such as phosphonic acid. Another copolymer also shown in FIG. 431I comprises thermoplastic urethane-co-sulfonated divinyl benzene (PTPU-co-sDVB) 6250. The ionomeric membranes as fabricated herein may contain a combination of hetero-ionomers, copolymers, micropores, permanent fillers, ionic liquids, and/or ionomeric dopants.

FIG. 431J illustrates various sulfonated copolymers of perfluoro-methylene-methyl-dioxolane (PFMMD) including perfluoro-methylene-methyl-dioxolane-co-perfluoro-methylene-dioxolane P((PFMDD-SA)-co-PFMD) 6251; perfluoro-methylene-methyl-dioxolane-co-chlorotri fluoroethylene P((PFMDD-SA)-co-CTFE) 6252; and perfluoro-methylene-methyl-dioxolane-SA-co-perfluorostyrene P((PFMMD-SA)-co-PFSt) 6253. Another copolymer shown is poly(dioxodihydro pyrrole-co-carbonyl sulfonyl fluoride-co-styrene-SA (PDDP-co-(CSFSt-SA)) 6254. The ionomeric membranes as fabricated herein may contain a combination of hetero-ionomers, copolymers, micropores, permanent fillers, ionic liquids, and/or ionomeric dopants.

Another ionomer 6255 shown in FIG. 431K combines a sulfonated phenyl group with a four-phenyl linear chain resulting in the hydrocarbon copolymer sulfonated polyphenylene-co-quaterphenol (sPPh-co-QPh). Another polymer comprises sulfonated polyamide-co-sulfonimide (sSPA-co-Slm) 6256. The ionomeric membranes as fabricated herein may contain a combination of hetero-ionomers, copolymers, micropores, permanent fillers, ionic liquids, and/or ionomeric dopants.

FIG. 431L illustrates various polyvinyl copolymers include cross-linked sulfonated polyvinyl alcohol PVA-x-SSA 6257; polyvinylidene fluoride-co-sulfonated polyvinyl alcohol (PVDF-co-PVA-sPVA) 6258; polyvinylidene fluoride-co-sulfonated polycarbonate (PVDF-co-sPC) 6258; and polyvinylidene fluoride-co-perfluorosulfonic acid (PVDF-co-PFSA) 6260. The ionomeric membranes as fabricated herein may contain a combination of hetero-ionomers, copolymers, micropores, permanent fillers, ionic liquids, and/or ionomeric dopants.

FIG. 431M illustrates a segmented two-monomer sequenced polymer involving ether and ketone groups. As represented schematically, sulfonated poly(ether ketone) 6261 with the generic formula sPExKy comprises two-to-five segments |A| through |E| sequenced in any order including repeats. Each segment may comprise ether {E}, sulfonated ether {sE}, ketone {K}, sulfonated ketone {sK}, or the null set Ø. Examples include sulfonated versions of poly(ether ketone) sPE₁K₁=sPEK; poly(ether-ether ketone) sPE₂K₁=sPEEK; poly(ether ketone-ketone) sPE₁K₂=sPEKK; poly(ether-ether ketone-ketone) sPE₂K₂=sPEEKK; and poly(ether ketone ether ketone-ketone) sPE₂K₃=sPEKEKK, where any specific segment may be sulfonated or not, so long that at least one segment is sulfonated or functionalized by an ionomer. Other variants may include poly(ether ketone ether ketone) sPE₂K₂=sP(EKEK); poly(ether-ether-ether ketone) sPE₃K₁=sP(EEEK); and poly(ether ketone-ketone-ketone) sPE₁K₃=sP(EKKK). Sulfonated and un-sulfonated blends may include sulfonated poly(ether ketone-co-(ketone ether ketone) sPEK-co-KEK also referred to as 2PEK; and sulfonated poly(ether-ether ketone)-co-poly(ether-ether ketone) sPEEK-co-PEEK. The ionomeric membranes as fabricated herein may contain a combination of hetero-ionomers, copolymers, micropores, permanent fillers, ionic liquids, and/or ionomeric dopants.

FIG. 431M also illustrates a segmented two-monomer sequenced polymer involving ether and sulfone groups. As represented schematically, sulfonated poly(ether sulfone) 6262 with the generic formula sPEₓSf_{z} comprises two-to-five segments |A| through |E| sequenced in any order including repeats. Each segment may comprise ether {E}, sulfonated ether {sE}, sulfone {Sf}, sulfonated sulfone {sSf}, or the null set Ø. Examples include sulfonated poly(ether sulfone) sPE₁Sf₁=sP(ESf); sulfonated poly(sulfone ether sulfone) sPE₁Sf₂=sP(SfESf) aka sP(EDSf); sulfonated poly(ether-ether sulfone) sPE₂Sf₁=sP(EESf); and sulfonated poly(ether sulfone ether sulfone) sPE₂Sf₂=sP(ESfESf). Poly(ether sulfone) can also be sequenced with phenyl groups or with fluorine such as poly(ether sulfone) (sP(PhESf)), sulfonated fluorinated polyethersulfone (sFPESf), and bis-hydroxyphenyl ether di-sulfone (BH-PhEDSf). The ionomeric membranes as fabricated herein may contain a combination of hetero-ionomers, copolymers, micropores, permanent fillers, ionic liquids, and/or ionomeric dopants.

FIG. 431N illustrates a segmented two-monomer sequenced polymer involving ketone and sulfone groups. As represented schematically, sulfonated poly(ketone sulfone) 6263 with the generic formula sPK_{y}Sf_{z} comprises two-to-five segments |A| through |E| sequenced in any order including repeats. Each segment may comprise ketone {K}, sulfonated ketone {sK}, sulfone {Sf}, sulfonated sulfone {sSf}, or the null set Ø. Examples include sulfonated poly(ketone-ketone sulfone) sPK₂Sf₁=sP(KKSf); sulfonated poly(ketone sulfone ketone sulfone) sPK₂Sf₂=sP(KSfKSf). Many ketone sulfone compounds also include aryl groups, described here below.

FIG. 431N also illustrates the most generic sequenced polymer involving aryl, ether, ketone, and sulfone groups in varying combinations and sequences. As represented schematically, sulfonated poly(arylene ether ketone sulfone) 6264 with the generic formula sP(A_{w}EₓK_{y}(Sf)_{z}) comprises two-to-ten segments, where for clarity's sake only |A| through |E| are shown, sequenced in any order including repeats. A nearly endless combination of sulfonated polymers combining arylene {A}, ketone {K}, sulfonated ketone {sK}, ether {E}, sulfonated ether {sE}, sulfone {Sf}, sulfonated sulfone {Sf}, and the null set Ø. The example shown comprises poly(arylene ether sulfone ether-sulfonated ketone-ether sulfone) (P(AESfE(sK)E(Sf))). The ionomeric membranes as fabricated herein may contain a combination of hetero-ionomers, copolymers, micropores, permanent fillers, ionic liquids, and/or ionomeric dopants.

FIG. 431O illustrates two polyvinyl difluoride (PVDF) copolymers both of which are bound to polyvinylidene pyrrolidone (PVP). In polyvinyl difluoride-co-polyvinyl pyrrolidone-co-polystyrene SA (PVDF-co-PVP-co-PSSA) 6265, the polyvinylidene pyrrolidone also forms a copolymer with sulfonated polystyrene (PSSA), while in copolymer 6266 comprising polyvinylidene fluoride-co-polyvinylidene pyrrolidone SA, only PVDF and PVP groups are present. The ionomeric membranes as fabricated herein may contain a combination of hetero-ionomers, copolymers, micropores, permanent fillers, ionic liquids, and/or ionomeric dopants.

Other PVDF copolymers are represented in FIG. 431P, specifically polyvinylidene fluoride-co-azobisiso butyronitrile-co-sulfopropyl acrylate (PVDF-co-AIBN-co-SPA) 6267 which includes both azobisiso butyronitrile (AIBN) and sulfopropyl acrylate (SPA). Copolymer 6269 called polyvinylidene fluoride-co-azobisiso butyronitrile-co-sulfopropyl acrylate-co-hexafluoropropylene (PVDF-co-AIBN-co-SPA-co-PFH) duplicates polymer 6267 except that it includes a fourth segment of hexafluoropropylene. By contrast, polyvinylidene fluoride-co-hexafluoropropylene (sPVDF-co-HFP) 6258 comprises only the PVDF and hexafluoropropylene groups. The ionomeric membrane as fabricated herein may contain a combination of hetero-ionomers, copolymers, micropores, permanent fillers, ionic liquids, and/or ionomeric dopants.

Fluorocarbon compounds may also form copolymers and grafted copolymers made in accordance with this invention as depicted in FIG. 431Q. These include the grafted copolymer poly(perfluoroalkoxy alkane)-g-polystyrene sulfonic acid (P(PFA)-g-PSSA) 6270 and cross-linked sulfonated poly(trifluorostyrene) sPTFS-x-(sPTFS-co-PTFS) 6271. The ionomeric membranes as fabricated herein may contain a combination of hetero-ionomers, copolymers, micropores, permanent fillers, ionic liquids, and/or ionomeric dopants.

Other ionomeric polymers made in accordance with this invention as depicted in FIG. 431R include biopolymers poly(dopamine-sulfonated dopamine) (P(DA-sDA) 6280 and sulfonated chitosan (sCS) 6281 and anhydrous polymers sulfonated poly phenylene bibenzimidazole (PBI-SA) 6282 and 6283. The ionomeric membranes as fabricated herein may contain a combination of hetero-ionomers, copolymers, micropores, permanent fillers, ionic liquids, and/or ionomeric dopants.

### Ionomer Electrochemistry.

The ionic group functioning as an electrically active site or electrochemically functional group in a polymer is commonly referred to an ionomer. Ionomers perform numerous tasks in polymer chemistry, especially in polymer membranes. Made in accordance with this invention, various roles of ionomers include performing and optimizing catalysis of chemical reactions, selectively filtering impurities and contaminants passing through ionomeric membranes, or engaging in ionic conduction. All of these functions are important in hydrogen-based energy production systems and operation.

Catalytic applications of ionomers include product manufacturing of fibers and materials, e.g. in membrane fabrication, or in a fuel cell by accelerating electrochemical activity otherwise too slow or thermodynamically unfavorable to be useful. For example, catalytic functions of an ionomer are valuable in efficiently promoting the formation or breaking of hydrogen bonds in hydronium ions, a key component of vehicular charge transport in the aqueous electrochemistry of fuel cells and water-to-hydrogen electrolysis. Other ionomeric functions described herein include the process of accelerating the rate of oxygen reduction reactions (ORR) at the interface between a cathode catalyst layer in a hydrogen or direct methanol fuel cell and to help prevent catalyst poisoning.

In high selectivity filtering applications needed as water pretreatment for water-to-hydrogen electrolysis, ionomers made in accordance with this invention can be used to enhance water desalination, wastewater treatment and recycling, water purification, and deionization. Using smaller pore sizes, the fabricated ionomeric membranes can also be used in scrubbers and air filters to protect fuel cell catalysts and membranes against air impurities and toxins able to damage catalyst metals and ionomeric groups. In comparison to conventional filters, the presence of the ionomers in a membrane electrochemically enhances attraction of charged impurities and polar molecules to the filter and enhances their retention after capture. The same purification technology is also adaptable to kidney electrodialysis.

In electrochemical device applications such as fuel cells and electrolyzers, the ionomer is the primary component of electrical conduction within an ion exchange membrane, the conductivity of which is determined by an ionomer's chemical composition, hydrophilicity, concentration, and attachment onto the membrane's polymeric matrix. An ionomer is by definition a ionized functional group fixed onto a polymer spine or lattice able to bond to and release ions.

In the case of a proton exchange membrane (PEM), the ionomer comprises a neutral acid bonded onto the polymer. In the presence of an aqueous solution, the acid loses a proton into solution leaving a negatively changed ion behind. As such, the ionomer in a PEM membrane comprises an immobile anion, a negatively charged ion able to attract, bond to, and release positively charged protons. The role of an immobile anion in a PEM is somewhat confusing because mobile anions act as negative charge carriers in IL doped AEM membranes. In a PEM however, the anion functions in charge transport of mobile cations, typically protons comprising ionized hydrogen (H⁺) or other positively charged ionized molecules.

In the case of a anion exchange membrane (AEM), the ionomer comprises a neutral base bonded onto the polymer. In the presence of an aqueous solution, the base gains a proton from solution creating a positively charge protonated immobile ion. As such, the ionomer in a AEM membrane comprises an immobile cation, a positively charged ion able to attract, bond to, and release negatively charged radicals such hydroxide ions (—OH). The role of an immobile cation in an AEM is somewhat confusing because mobile cations act as positive charge carriers in IL doped PEM membranes. In a AEM however, the anion functions in charge transport of mobile cations, typically protons comprising ionized hydrogen (H⁺).

So while a mobile cation in a PEM transports positive charge an immobile cation forms the ionomer in a AEM fuel cell. Conversely, while a mobile anion in an AEM transports negative charge an immobile anion forms the ionomer in a PEM fuel cell. In other words, an inventive PEM membrane made in accordance with this invention comprises an inert polymer with an immobile anion ionomer optionally enhanced by cations from ionic liquid doping. Likewise, inventive AEM membrane made in accordance with this invention comprises an inert polymer with an attached immobile cation ionomer optionally enhanced by anions supplied by ionic liquid doping.

Ionomers can be attached onto a polymer backbone by two means—either as an ionone, a functional group bonded ‘on-chain,’ i.e. within the polymer's spine; or as part of a pendant where the ionomer is attached at the terminus of a side chain bonded onto the polymer spine. In ionones where the ionomer is embedded within the polymeric backbone or with a cyclic ring such as a phenyl group, the challenge is that hydrophobic molecules in the polymer backbone can repel both water and hydronium needed to transport protons to and from the ionomer.

Accordingly, the polymeric chain's proximity to the ionomer impedes ion exchange thereby limiting conduction. This consideration is particularly an important factor when an ionomer's primary charge transport involves hopping conduction, i.e. the Grotthuss mechanism and when the main polymer is hydrophobic such as PTFE.

In such instances, performance of the film can be enhanced by instead attaching the ionomer to the terminus of a sidechain, the length of which may vary depending on how hydrophobic the main polymer is. Pendant attached ionomers thereby provide a greater degree of freedom in membrane design and ionomer performance but may reduce the structural durability of a film, especially for very long sidechains.

In proton exchange membranes, acidic groups attach themselves to the polymeric membrane during molding forming immobile functional groups, i.e. ionomers. These ionomers enable ion conduction in the film, remaining permanently affixed onto the polymer matrix throughout the use life of the membrane. The ionomers attach either as ionones onto the main chain or cyclic rings, or alternatively as termini of sidechain pendants. Without the presence of these ionomers, the undoped pristine membrane is non-conductive, essentially comprising an insulating or semi-insulating dielectric film.

The function of these immobile acids in a PEM membrane is to (i) attach to the spine of the membrane polymer either through a covalent bond, grafted sidechain, or in some cases via a hydrogen bond; (ii) participate in charge transport in the membrane by bonding to and releasing protons or other mobile cations traversing the conducting polymeric matrix; (iii) contribute to membrane conduction through a combination of hopping conduction of protons and vehicular transport of mobile hydronium cations; (iv) facilitate conduction via a combination of diffusion current and drift currents depending respectively on proton concentration gradients and electric fields present within and across the membrane; and (v) control hydration and membrane water concentrations consistent with membrane current densities for varying temperatures and relative humidity levels.

Together with the base polymer, sidechains and their ionomers may also influence certain material IEM film properties such as porosity, fuel crossover, hydrostatic swelling, film flexibility, mechanical strength, durability, coefficient of temperature expansion (CTE), temperature cycle life, humidity cycle life, resilience to corrosive chemicals, and immunity against environmental toxins such as carbon monoxide.

As described previously, these membrane-attached acids function as ionomers participating in PEM conduction by first releasing a hydrogen ion turning the neutral acid into an immobile anion then subsequently capturing free hydrogen (H⁺) ions or proton from hydronium ions before repeating the process. Numerous conduction paths exist in an ionomeric proton exchange membrane including proton capture (deprotonation) and release (protonation, ionization). Proton capture includes transfer from the anode catalyst layer to an ionomer, ionomer capture of free protons from solution, ionomer extraction of protons from hydronium ions, transfer of protons from other ionomers, and as applicable transfer of protons from ionic liquid mobile cations [IL_{c}]⁺.

The release of protons from an ionomer includes release of a free hydrogen ions into solution, proton transfer to another ionomer, proton transfer into water forming hydronium, proton transfer to an ionic liquid, or proton transfer to the cathode catalyst layer finalizing in an oxygen reduction reaction (ORR) combining protons and oxygen into water. The rate of these various processes depends on the concentration of ionomers, hydration levels, solution pH, ambient conditions, and the fraction of ionomers comprising protonated acids and deprotonated immobile anions.

In anion exchange membranes the isomeric groups act as bases rather than acids, releasing anions such as hydroxide radicals (—OH) into solution thereby converting basic ionomers into immobile cations before capturing another hydroxide radical (—OH) returning the ionomer back into a neutral base. As the dual process of a proton exchange membrane, the release of hydroxide from an ionomer in a AEM may be considered as gaining a positive charge, i.e. protonation. Conversely recapturing a hydroxide radical (—OH) may be considered as eliminating positive charge, vis-h-vis deprotonation.

Ironically, water also participates in the vehicular transport of hydroxide in solution. In accordance with the principal of charge neutrality, In the autoionization of water, a proton is transferred from one water molecule to another thereby splitting water into a protonated hydronium cation [H₃O]⁺ and a hydroxide [OH]⁻ anion, i.e. where 2H₂O⇄[H₃O]⁺ [OH]⁻. Although proton ion exchange membranes generally outperform AEMs because hydrogen is more mobile than hydroxide, anion exchange membrane offer cost advantages by avoiding a heavy reliance on expensive noble metals like platinum and palladium as catalysts.

The inventions described herein including micropores using sacrificial fillers, the inclusion of permanent fillers into a membrane, hetero-ionomers, and endoskeletal support are all equally compatible with anion exchange membranes as they are with proton exchange membranes.

### Ionomer Ionization.

As described, IEM fuel cells may either be cationic or anionic depending on whether the ionomers are able to transport positive or negatively charged ions. Necessarily the ionomers in an IEM must be opposite in polarity of the charges they conduct. For an anion exchange membrane (AEM), the charge carriers transported through the matrix are mobile negatively-charged anions such as —OH radicals. Accordingly, the ionomeric groups in the AEM necessarily comprise positively-charged cations in order to contribute to conduction, vis-h-vis an anionic IEM contains mobile anions as charge carriers and immobile cation ionomers supporting charge hopping conduction therein.

Conversely in proton exchange membrane (PEM), the charge carriers transported through the matrix are mobile positively-charged cations such as ionized hydrogen H⁺ and H₃O⁺ hydronium ions, both of which manifest a net positive charge by an excess of protons. In order to participate in charge hopping conduction of cations, the ionomeric groups forming a PEM must contain immobile anion ionomers. In other words, a PEM membrane contains mobile charges of H⁺ ionized hydrogen and H₃O⁺ hydronium ions combined with deprotonated acids comprising immobile anion ionomers.

The construction of cationic fuel cell comprises a proton exchange membrane (PEM) separating an anode and cathode regions. In PEMFC operation (i) hydrogen gas or methanol is supplied to the anode as fuel where the excess unspent hydrogen is recirculated; (ii) catalysts rip electrons from protons of the incoming fuel; (iii) the released protons travel across the ionomeric polymer electrolyte able to conduct cations but preventing electron conduction; and (iv) upon entering the cathode, the protons recombine with electrons and oxygen supplied to the cathode to form water. The water is mostly removed from the cathode as effluent along with any unused oxygen or air. In a hydrogen fuel cell the only reaction byproduct is water. In a direct methanol fuel cell, however the process of ionizing methanol releases a small amount of the greenhouse gas carbon dioxide (CO₂) which appears as waste gas in the hydrogen regress.

Some of the generated water formed in the cathode back diffuses into the membrane forming an aqueous solution of mobile hydrogen ions and hydronium ions. The polymeric matrix includes un-ionized electrically neutral acids and immobile anionic ionomers, both attached to the polymeric backbone or sidechains. During steady state operation with a constant supply of fuel and a constant electrical load, fuel cell operation is governed by an electrochemical reaction where the relative concentrations of free and immobile ions within the PEM electrolyte are in equilibrium governed by fundamental physical laws of conservation of charge and conservation of mass.

Specifically the mass of the fuel and oxygen influxes must equal the mass of the water effluent less the water remaining in the membrane film. Conservation of mass may be considered as a special case of the general law “what goes in must come out except for what stays there.” Conservation of charge, the principle that the total electric charge in an isolated system never changes. In the context of a fuel cell, charge conservation means charge entering the fuel cell must balance charges contained within the cell less those removed.

Consider a polymeric matrix containing membrane-bound acids having the generic chemical composition (A⁻)H⁺ where H⁺ represents a hydrogen ion and (A⁻) represents an immobile anion or in alternate notation [AH]⁰ referring to a neutral acid. The superscript is included to highlight the fact that the un-ionized acid has zero net charge, Mechanistically, in an aqueous solution, i.e. when the polymeric membrane is hydrated, some fraction of the immobile acids become ionized by losing a proton into solution, a mechanism referred to as deprotonation. When the acid groups are deprotonated they assume a net negative charge state forming an anion. Because of their ability to attract, attach to, and subsequently release protons from solution, the deprotonated acid groups form ionomers.

The population of ionized and deionized acids in an IEM membrane are not static but vary with current conduction, temperature, and humidity as well as by the composition of the membrane. In steady state operation, at any given moment some ionomers are losing protons while other ionomers are gaining protons. Starting with a charge neutral membrane comprising ‘m’ some portion ‘n’ of the acids will spontaneously ionize into ionomers, whereby the quality of un-ionized acids is given as (m−n). In terms of charge balancing, this mechanism can be written by the bidirectional reaction

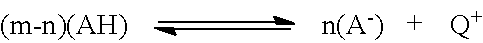

where n represents the number of acid groups ionized into ionomers and (m−n) describes the portion of functional groups remaining as charge neutral acids. The ratio α=[n/m] can be interpreted as the ionization constant of acid molecules converting from neutral acids into electrically active immobile anionic ionomers and mobile cations of hydrogen. Another term for this constant is DPP, an acronym for the degree of deprotonation. Substituting the ionization constant (m−n)=(m−αm)=m(1−α) in which case the equation becomes

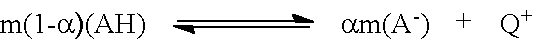

Defining the concentrations [AH⁰]≡m(AH) and [A⁻]≡m(A⁻) having units of either mol/L, mol/cm³, or charge/cm³, then the reaction equation simplifies into concentration-based formula

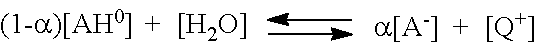

The degree of deprotonation is a function of the type of acid and hydration of the membrane. At room temperature [AH]⁰ will spontaneously split into ionized anion [A⁻] and hydrogen [H⁺] components, in accordance with the equilibrium reaction [AH⁰]⇄[A⁻]+[H⁺]. In the presence of water, however, ionized hydrogen [H⁺] combines with water [H₂O] to form hydronium ions [H₃O+] by the reaction [H⁺]⁺[H₂O]→[H₃O⁺] with virtually no hydrogen existing as free protons. In such case, the acid dissociation equation can be expressed as [AH⁰]+[H₂O]⇄[A⁻]+[H₃O⁺] where all three solutes are mobile in a solvent of water.

It should be mentioned in the lexicography of ionic liquids, it is common to write the ionic valency for mobile cations and anions outside the brackets such as [AH]⁰ and [A]⁻ while for ionomeric membranes, inclusion of the charge state inside the bracket is more common. Although there is no fundamental difference in meaning, this application adopts the same conventions to be more easily cross-checked against published literature in the art.

The measure of ionization of an acid in solution, i.e. a liquid acid, is thereby determined by its Kₐ value—the multiplicative product of the ionized anion [A⁻] and hydrogen [H⁺] concentrations divided the concentration of the un-ionized neutral acid [AH]⁺, as given by the relation

$${K}_{a} = \frac{[ {A}^{+} ] [ {H}^{+} ]}{{[ HA ]}^{0}} ≅ \frac{[ {A}^{+} ] [ {H}_{3} {O}^{+} ]}{{[ HA ]}^{0}}$$

For convenience the value can be re-expressed logarithmically as the constant pKₐ whereby

$${pK}_{a} = - log ( {K}_{a} ) = - log ( \frac{[ {A}^{+} ] [ {H}^{+} ]}{{[ HA ]}^{0}} ) ≅ - log ( \frac{[ {A}^{+} ] [ {H}_{3} {O}^{+} ]}{{[ HA ]}^{0}} )$$

Solving for Ka as a function of pKₐ gives yield the insightful relation

$${K}_{a} = \frac{[ {A}^{+} ] [ {H}^{+} ]}{{[ HA ]}^{0}} ≅ \frac{[ {A}^{+} ] [ {H}_{3} {O}^{+} ]}{{[ HA ]}^{0}} = 1 {0}^{- {pK}_{a}}$$

This relation means shows the more negative a pKₐ value is, the greater the Ka value is meaning the number of anions and cations are significantly greater than remaining neutral acid groups. For example in the case of sulfonic acid pKₐ varies from −2 to +1, with corresponding Ka values of 100 to 14 0.1 times that of the unionized acids respectively, or as fraction of total solutes 99% to 9% ionized. At pKₐ=0, the numerator and denominator are equal meaning only 50% of the acid groups are ionized.

Typically Nafion® and related PFSA ionomers reportedly Kₐ=0.176 meaning roughly α=15% of the acid groups ionize into anions, whereby 85% of the acid groups remain un-ionized outnumbering the ions by a factor of 5.6-to-1. This pKₐ corresponds to a pKₐ=0.754. By contrast, phosphonic is a weaker acid than sulfonium where pKₐ=1.3 for the first dissociation and therefore Kₐ=0.05 meaning the neutral acid groups outnumber the ionized groups 20-to-1, meaning only 4.8% of the acid groups are ionized. A list of acids used in accordance with this invention to form ionomeric membranes are described here below. The list is exemplary but not intended to be limiting or exhaustive.

In accordance with this invention, acids with pKₐ values below −1.5 and ionization constants α>95% as denoted by a single asterisk (*) are considered very strong acids and should not be used in ion exchange membranes except in very dilute concentrations as they can degrade the structural integrity of the polymer. Chlorinated acids such as perchloric acid, chlorosulfonic acid, and hydrochloric acid are altogether avoided as they are very corrosive, degrading the catalyst metal atoms and damaging the fuel cell assembly. Despite its relatively high pKₐ value of 3.17, hydrofluoric acid denoted by ** is extremely corrosive and biologically dangerous as it disintegrates skeletal bone.

As such, HF is altogether avoided in the inventive membranes at any concentration. Referring to the table again, aqueous sulfonic acid and amide conjugate acid vary widely in pKₐ values from −2-to-0 depending on the specific acid moiety. The more useful range for ionomeric applications includes pKₐ values from −0.5 to +1.5 include trifluoroethyl (TFE) bound sulfonic acid ionomers referred to PFSA-SO₃H such as those in Nafion® and related fluorocarbon films with its pKₐ=+0.754 corresponding to a 15% ionization level. As shown, other IEMs made in accordance with this invention include membrane-bound acids with between 15% and 3% ionization constants including sulfamic acid (H₃NSO₃), the first dissociation of phosphonic acid (H₃PO₃), the first dissociation of sulfosuccinic acid (C₄H₆O₇S), and diethylphosphate DEP (C₄H₁₀O₄P). It also includes various weaker moieties of aqueous sulfonic acid and amide conjugate acids.

| Acid | pKₐ | Acid dissoc Kₐ | | Ionized ≤ α | |
|---|---|---|---|---|---|
| trifluoromethanesulfonic acid | −14 | 10¹⁴ | | 100% | |
| (triflate, CF₃SO₃H)* | | | | | |
| perchloric acid (HClO₄)* | −10 | 10¹⁰ | | 100% | |
| hydroiodic acid (HI)* | −10 | 10¹⁰ | | 100% | |
| hydrobromic acid (HBr)* | −9 | 10⁹ | | 100% | |
| chlorosulfonic acid (HSO₃Cl) | −6 | 10⁶ | | 100% | |
| hydrochloric acid (HCl)* | −6 | 10⁶ | | 100% | |
| sulfuric acid (H₂SO₄), 1^{st} dissoc * | −3 | 10³ | | 99.9% | |
| nitric acid (HNO₃)* | −1.4 | 25.1 | | 96.2% | |
| sulfonic acid, solute (RSO₃H) | −2 to 0 | 100-1 | | 99%-50% | |
| amide conjugate acid (—CONH) | −1 to −0.5 | 10-3.2 | | 91%-76% | |
| sulfonic acid ionomer (PFSA-SO₃H) | +0.754 | 0.176 | | 15% | |
| sulfamic acid (H₃NSO₃) | +1 | 0.10 | | 9.1% | |
| phosphonic acid (H₃PO₃), 1^{st} dissoc | +1.3 | 0.050 | | 4.8% | |
| sulfosuccinic acid (C₄H₆O₇S), 1^{st} dissoc | +1.5 | 0.032 | | 3.1% | |
| diethylphosphate (DEP) | +1.5 | 0.032 | | 3.1% | |
| phosphoric acid (H₃PO₄), 1^{st} dissoc | +2.15 | 0.0071 | | 0.70% | |
| pyruvic acid (C₂H₄O₃) | +2.49 | 0.0032 | | 0.32% | |
| phosphotungstic acid (H₃[P(W₃O₁₀)₄]) | +3.1 | 0.00079 | | 0.079% | |
| citric acid (C₆H₈O₇), 1^{st} dissoc | +3.1 | 0.00079 | | 0.079% | |
| hydrofluoric acid (HF) ** | +3.17 | 0.00068 | | 0.068% | |
| glycolic acid (C₂H₄O₃) | +3.83 | 0.00015 | | 0.015% | |
| carboxylic acid (R-COOH) | +4 to +5 | 0.0001-10 | ppm | 0.01%-10 | ppm |
| acetic acid (AA) | +4.76 | 17.3 | ppm | 17.3 | ppm |
| butyric acid (C₃H₇COOH) | +4.82 | 15.1 | ppm | 15.1 | ppm |
| phenol, phenyl hydroxide (C₆H₅OH) | +10 | 0.1 | ppb | 0/1 | ppb |

| | | | |
|---|---|---|---|
| ethyl lactate (C₅H₁₀O₃) | +14.2 | 6.3 × 10⁻¹⁵ | 6.3 × 10⁻¹⁵ |

Acids ionized between 1% and 0.1% still can function individually as ionomers or in hetero-ionomer proton exchange membranes described herein. They include the first dissociation of phosphoric acid (H₃PO₄) or pyruvic acid (C₂H₄O₃). Acids with ionization fractions between 0.1% and 0.05%. i.e. with pKₐ values of around +3.1 such as phosphotungstic acid (H₃[P(W₃O₁₀)₄]) and the first dissociation of citric acid (C₆H₈O₇) while not effective as membrane-bound ionomers, can be used to form crystalline structures of PWA or CA. As described previously in this application, these ionomeric crystals when added into a membrane as a permanent filler enhance film conductivity without affecting pH, ionomer ionization constants, or membrane integrity.

Finally, any acid or conjugate base with pKₐ>+3.5 and ionization constants α<0.02% are not effective in providing meaningful charge transport but can be used as a chemical buffer to regulate pH and swelling in the PEM despite changing levels of ambient humidity and conducted current impact film hydration. A blend of a conjugate acid and a weak base (or conversely a mix of a weak acid and its conjugate base forms a buffer solution, resisting pH change in response to limited additions of a strong acid or a strong base.

Made in accordance with this invention, an ion exchange membrane may comprise a polymer containing moderately ionized acid species with pKₐ values between 0 and +3.5 including sulfonic acid, sulfamic acid, phosphonic acid, sulfosuccinic acid, diethylphosphate, phosphoric acid, pyruvic acid, phosphotungstic acid, citric acid, and dilute forms of amide conjugate acids. These acids may be used singularly or in combination to form
membrane-bound acids as homo-ionomers;
two-or-more membrane as hetero-ionomers;
membrane-bound acids combined with dilute free acid radicals functioning as buffers against pH variation;
membrane-bound acids combined with dilute free acid radicals, i.e. ionic liquid dopants; and
membrane-bound acids as homo-ionomers, combined with crystalized acids or fillers such as PMMA, MOFs, DSSQs, etc. containing ionomeric acid groups as permanent membrane fillers.

As described previously, extremely strong acids having very negative pKₐ values, i.e. below pKₐ≤−2, are not recommended except when used in extremely dilute concentrations as they can degrade polymer integrity and shorten film lifetime. Chlorinated acids are to be avoided altogether for corrosion complications. Hydrofluoric acid are not be used for health concerns to humans and to the biosphere.

In accordance with this invention, the distinction among ionomers, ionomeric fillers, and ionic liquids, and buffers as applied in the ion exchange membranes described herein is essentially defined by carrier mobility. In an IEM, an ionomer is an acid bound to the polymeric backbone which becomes ionized to form an immobile cation or anion able to support hopping conduction. Specifically in a PEM, the acid donates a mobile proton into solution through an ionization process of deprotonation leaving behind an immobile anion. Conversely in a IEM, the acid absorbs a mobile proton from solution or releases a hydroxide group as a solute through an ionization process of protonation forming an immobile cation.

An ionomeric filler is nearly the same except the acid is a functional group attached to a crystal or atomic structure, e.g. a phosphotungstic crystal or functionalize metal organic framework (MOF), whose structure is sufficiently large to lock the host molecule in place with the polymer's molecular matrix even though it is not necessarily chemically-bound or grafted onto the polymer itself. The resulting ionomeric groups introduced during casting or molding thereby represent permanent ionomeric fillers within the membrane.

Ionic liquids and buffers by contrast are diffuse fluids within the polymer's atomic matrix introduced during the membrane's manufacturing process. Specifically, ionic liquid doping comprises a permanent filler of an organic salt that melts into mobile cations and anions at room temperature to provide additional charge carriers not associated with immobile ionomers. Buffers include either a mixture of a weak acid and its conjugate base or conversely a weak base and its conjugate acid designed to regulate pH and impede chemical degradation and structural damage to the membrane polymer and its endoskeletal support.

Made in accordance with this invention these liquid fillers are constrained by the endoskeleton from leaking out the sides of the membrane by the inert insoluble composition of the pillars such as plastic or PTFE forming the skeleton. An added feature to prevent lateral leakage is the wider exoskeletal frame that circumscribes the outer edge of every singulated membrane, providing added structural support impervious to acids and ions. In this invention, ionic liquid or buffer leakage in a direction perpendicular to the membrane is prevented through containment provided by the CCM's heterogenous catalyst layer comprising a combination of catalyst metals, carbon, PTFE nanoparticles, and other fillers such as boron nitride, MOFs, zeolites, crystals, and organic fillers.

### Film Hydration and Conductivity.

The electrochemical reaction to synthesize a proton exchange membrane (PEM) comprises forming a polymeric backbone attached to sidechains and acid termini spontaneously ionizing to form anionic ionomers. To determine the molecular concentration N_{PFSA} for an ionomeric polymer such as Nafion, we can use the definition:

$${N}_{PFSA} = \frac{ρ}{EW}$$

where N_{PFSA} is the PFSA molecular concentration in moles per liter (mol/L) or moles per cubic centimeter (mol/cm³), ρ is material density in g/cm³, and EW is the ionomer's equivalent weight—the mass of the polymer in grams that contains one mole of ionomeric acid groups. Using Avogadro's number, N_{A}=6.022×10²³ molecules/mol, moles can be converted into the number of molecules. The chemical and atomic compositions for three different PFSA ionomeric films are described and compared in the following table, namely Nafion® 1100, 3M® (729), and Aquivion® 720.

As listed, for Nafion® 1100 or similar long sidechain PFSA ionomers the dry molecular gravimetric density is ρ=1.95 g/cm³ and the EW=1100 g/mol producing a molar concentration N_{PFS} A=(1.95 g/cm³)/(1100 g/mol)=0.001772 mol/cm³=1.178 mol/L. Using Avogadro's number, N_{A}=6.022×10²³ molecules/mol, the molecular concentration of PFSA is (N_{PFSA})(N_{A})=(0.00178 mol/cm³)(6.022×10²³ molecules/mol)=1.071×10²¹ PFSA groups/cm³. Since each Nafion® multi-segment string contains one sulfonic acid group, the number of sulfonic acid groups per cm³ volume is the same as the number of Nafion© molecules per cm³. In m=6.6 backbones, one TFE segment with an attached pendant is accompanied by 6.6 inert PTFE segments, making the film 13% hydrophilic.

For Aquivion® 720 or similar short sidechain PFSA ionomers, the dry molecular density is ρ=1.93 g/cm³ and the EW=720 g/mol. Calculating M_{PFSA}=(1.93 g/cm³)/(720 g/mol)=0.002681 mol/cm³=2.681 mol/L. Using Avogadro's number, N_{A}=6.022×10²³ molecules/mol, the molecular density of PFSA is M(N_{A})=(0.002681 mol/cm³)(6.022×10²³ molecules/mol)=1.614×10²¹ PFSA groups/cm³.

In contrast to its molecular concentration, the actual atomic composition of long sidechain Nafion® 1100 with m=6.6 comprises 20 atoms of carbon (C), 39 atoms of fluorine (F), 5 atoms of oxygen (O), 1 atom of sulfur (S) totaling 65 atoms of varying mass not counting the sulfonic acid ionomer's hydrogen ion. Given the molecular density of 1.071×10²¹ PFSA groups/cm³, this means the atomic concentration of PFSA such as Nafion® 1100 can be found by multiplying the 65 atoms/PFSA molecule by the molecular density of PFSA at 1.071×10²¹ molecules/cm³ resulting in an atomic density of 6.96×10²² atoms/cm³.

Short sidechain PFSA molecules such as 3M® (729) and Aquivion® 720 have lower equivalent weights than Nafion® 1100, roughly EW≈725±5 resulting in molar ionic densities of 2.7 mol/L or molecular concentrations of approximately 1.6×10²¹ PFSA/cm³, roughly 50% greater than the ionic density long-sidechain Nafion®. This higher ionomer concentration means short sidechain PFSA molecules offer higher conductivity but at the expense of greater water absorption and swelling, with adverse consequences for use life. With 3.5≤m≤4.4 roughly one TFE spinal segment out of five include an attached hydrophilic sidechain. The remaining segments comprise hydrophobic PTFE.

Given the molecular density of 1.071×10²¹ PFSA groups/cm³, this means the atomic concentration of short sidechain PFSA can be found by multiplying the 43 atoms/PFSA molecule by the molecular density of PFSA resulting in an atomic density of 6.9×10²² atoms/cm³, almost identical long sidechain PFSA. Despite having similar atomic densities by weight or by atomic number, short sidechain PFSA contains 50% more ionomers resulting in enhanced conductivity.

Somewhat surprisingly however, at 6.9×10²² cm⁻³, PFSA has a higher atomic density than single crystal silicon at 5.0×10²² cm⁻³. Moreover, at 1-to-1.5×10²¹ ionomers/cm³ PFSA contains 100× more conducting ionomers than dopant atoms in heavily doped P-type silicon at 4×10¹⁹ B/cm³. Although silicon comprises a regularly patterned ultra-pure matrix of atoms arranged in a diamond crustal lattice and interrupted infrequently by boron dopant atoms, by contrast, PFSA comprises a quasi-amorphous quasi-crystalline structure.

| PFSA | Nafion ® | 3M ® | Aquivion ® | |
|---|---|---|---|---|
| Membrane | 1100 | (729) | 720 | Units |
| sidechain type | long (LSC) | short (SSC) | short (SSC) | — |
| equivalent | 1100 | 729 | 720 | g/eq |
| weight EW | | | | |
| total acid | 0.91 | 1.37 | 1.39 | meq/g |
| capacity TAC | | | | |
| atomic density ρ | 1.98 | 1.93 | 1.93 | g/cm³ |
| molar ionic | 1.178 | 2.65 | 2.681 | mol/L |
| density Nᵢₒₙ | | | | |
| molecular | 1.071 × 10²¹ | 1.594 × 10²¹ | 1.614 × 10²¹ | PFSA/cm |
| ionic density Nᵢₒₙ | | | | |
| atomic density | 6.96 × 10²² | 6.85 × 10²² | 6.85 × 10²² | atoms/cm³ |
| N_{PFSA} | | | | |
| repeats m | 6.6 | 3.5 | 4.4 | groups |
| carbon C | 7 + 13 = 20 | 6 + 7 = 13 | 4 + 9 = 13 | atoms |
| fluorine F | 13 + 26 = 39 | 11 + 14 = 25 | 7 + 18 = 25 | atoms |
| oxygen O | 5 | 4 | 4 | atoms |
| sulfur S | 1 | 1 | 1 | atoms |
| total atomic | 65 | 43 | 43 | atoms |
| number | | | | |

Comparing PFSA to silicon also provides some useful insight explaining film conductivity, the major difference being the influence of hydration and ambient humidity of conductivity. Because of the closed structure of semiconductor crystals, water is unable to penetrate the atomic matrix and therefore uninfluential in the material conductive properties. By contrast, the porosity of many ionomeric polymers, especially PFSA, easily accommodate the absorption of water into its atomic matrix either from ambient humidity or from the cathodic catalyst-membrane interface. To include the role of water in ionomeric conduction, the electrochemical reaction equation is modified to

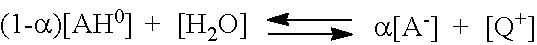

where the hydration factor λ also known as water uptake is defined as the ratio of water concentration [H₂O] where

$$λ ≡ \frac{[ {H}_{2} O ]}{[ {A}^{-} ]} = \frac{[ {H}_{2} O ]}{[ {HA}^{0} ]}$$

Verified experimentally for a wide spectrum of aqueous ion exchange membranes, interstitial water content directly affects the quantity α[A⁻] of ionized acid groups. The role of water is especially significant at low levels of hydration but then diminishes asymptotically at higher hydration levels as modelled using the empirical form

$$α = \frac{λ}{λ + {ξ}_{H 2 O}}$$

where the hydration fitting parameter ξ_{H2O}=14.

The following table exemplifies the profound influence of hydration of PFSA ionomer conduction properties. Specifically, the hydration factor λ describes the ratio of interstitial membrane water molecules to sulfonic acid groups. The ionization constant α=f(λ) describes the fraction of acid groups ionized. The ion concentration α[A⁻] thereby describes the concentration of ionized acid groups per unit volume deprotonated into immobile anions.

| | | Relative | Relative | Ion |
|---|---|---|---|---|
| Hydration | Ionization | Humidity | Humidity | Concentration |
| λ (%) | α (%) | RH_{25° C.} (%) | RH_{80° C.} (%) | α[A⁻] (q/cm³) |
| 1.55 | 10 | 38 | 51 | 1.0685 × 10²⁰ |
| 2.47 | 15 | 50 | 62 | 1.8075 × 10²⁰ |
| 3.50 | 20 | 58 | 70 | 2.1438 × 10²⁰ |
| 6.00 | 30 | 71 | 80 | 3.2157 × 10²⁰ |
| 9.33 | 40 | 79 | 86 | 4.2877 × 10²⁰ |
| 14.0 | 50 | 85 | 90 | 5.3596 × 10²⁰ |
| 21 | 60 | 89 | 93 | 6.4315 × 10²⁰ |
| 33 | 70 | 93 | 96 | 7.5262 × 10²⁰ |
| 56 | 80 | 96 | 97 | 8.5753 × 10²⁰ |
| 126 | 90 | 98 | 99 | 9.6472 × 10²⁰ |
| — | 100 | 100 | 100 | 1.0719 × 10²¹ |

1 As modelled, the ionization constant α and the concentration of deprotonated ionomers α[A⁻] do not exhibit a linear dependence on hydration factor λ For example, at λ=6, roughly 30% of the acid groups are ionized and at λ=14 over half are. Estimates of the relative humidity at 25° C. and 80° C. as listed are based on the relation λ=(TC·RH)/(1−RH) where TC is a temperature coefficient and RH is the relative humidity. From the aforementioned analysis, the activation of sulfonic acid groups in PFSA at %=15% means the carrier concentration is roughly α(N_{PFSA}(N_{A}))=0.15(1.0719×10²¹ PFSA groups/cm³)=1.81×10²⁰ active ionomers/cm³. At this activation, this deprotonated ionomer concentration represents approximately (1.81×10²⁰ cm⁻³)/(6.96×10²² cm⁻³)=1.81/696=0.0026=0.26% of the atomic density, or roughly one part per 385 atoms. Some debate however remains as to what is the maximum percentage of ionomers that can be ionized.

For comparison's sake, the maximum boron ‘acceptor’ concentration in degeneratively doped P-type silicon is approximately 4×10¹⁹ cm⁻³, 0.08% of its atomic density despite nearly 100% the dopant atoms being ionized. This limitation in the maximum dopant concentration is due to the solid solubility of boron in silicon.

| | Density | Atomic conc | Humidity | Hydration | Ionization | | Conductivity |
|---|---|---|---|---|---|---|---|
| | variable: | | | | | | |
| | ρ | N_{atomic} | RH, 25° C. | λ | α | α[A⁻] | σ (25° C.) |
| | units: | | | | | | |
| Material | g/cm³ | atoms/cm³ | % | % | % | q/cm³ | S/cm |
| PFSA | 1.98 | 6.96 × 10²² | 38 | 1.55 | 10 | 1.0685 × 10²⁰ | 5 × 10⁻³ |
| Nafion | | | 58 | 3.50 | 20 | 2.1438 × 10²⁰ | 8 × 10⁻³ |
| 1100 | | | 79 | 9.33 | 40 | 4.2877 × 10²⁰ | 1.2 × 10⁻² |
| | | | 89 | 21 | 60 | 6.4315 × 10²⁰ | 1.3 × 10⁻² |
| | | | 96 | 56 | 80 | 8.5753 × 10²⁰ | 1.4 × 10⁻² |
| | | | 100 | — | 100 | 1.0719 × 10²¹ | 1.45 × 10⁻² |
| PFSA | 1.93 | 6.85 × 10²² | 49 | 2.38 | 10 | 1.6139 × 10²⁰ | 2 × 10⁻² |
| Aquivion | | | 68 | 5.35 | 20 | 3.2778 × 10²⁰ | 5 × 10⁻² |
| 720 | | | 85 | 14 | 40 | 6.4556 × 10²⁰ | 1 × 10⁻¹ |
| | | | 93 | 32 | 60 | 9.6834 × 10²⁰ | 1.3 × 10⁻¹ |
| | | | 97 | 86 | 80 | 1.2911 × 10²¹ | 1.4 × 10⁻¹ |
| | | | 100 | — | 100 | 1.6139 × 10²¹ | 1.5 × 10⁻¹ |
| P-type Si | 2.3 | 5.00 × 10²² | NA | NA | 100 | 4.0 × 10¹⁹ | 350 |

Comparing PFSA to silicon, with only 15% to 20% of its acid groups ionized PFSA film contains a minimum of 1.81×10²⁰ cm⁻³ conducting sites compared to that of silicon's 4×10¹⁹ cm⁻³. Despite its lower carrier concentration, silicon is substantially more conductive than any ionomer.

One common measure of electrical conduction for any material is the conductivity parameter σ=J/E defining the relationship between current density J≡I/A and electric field E. As shown in the table, the conductivity of ionomeric polymers is generally less than σ≤0.2 S/cm while heavily doped P-type silicon has a conductivity of σ≤350 S/cm. Care should be taken not to confuse the SI standard MKS unit system of 20 S/m with the cgs system value 0.2 S/cm commonly employed in microelectronics and material science.

For example, the peak conductivity of long sidechain Nafion® 1100 membranes is approximately σ=0.015 S/cm while short sidechain PFSA membranes such as Aquivion 720 exhibit values of σ=0.15 S/cm, an order-of-magnitude more conductive. This means P-type silicon has conductance advantages of over long and short sidechain PFSA of 17,500× and 1,750× respectively. The higher conductivity of the short sidechain PFSA over LSC PFSA cannot be explained by ionomer density, accounting for at most roughly 1100/720=1.53 or only 53% better conduction. Instead, the role of water must be considered in charge transport. Again, further insight can be obtained by comparing PFSA to P-type silicon.

Using the definition of hole drift current Jₕ=−Qₕvₕ where is the average drift velocity vₕ of a hole and where Qₕ is the total hole charge Qₕ=−qN_{A} where q is an elemental charge of a hole and Na is the number of acceptor dopant atoms. In classical electromagnetics, the electrostatic force F imposed on charge by an electric field E is given by F=QE. Equating the electrostatic force with Newton's law F=m*a where m* is the effective mass of the charge and the variable ‘a’ is its acceleration, then QₕE=m*a or solving for acceleration α=QₕE/m*. Carrier velocity, the average speed of positive charges Qn in an electric field is given by vₕ=aτₜₜ where τₜₜ is referred to by any number of names such as relaxation time, transit time, or collision time describing the average time a carrier requires to pass its energy on to another atom or molecule. Combining acceleration and velocity according to Newton's laws of motion, the resulting equality known as the ‘drift transport equation’ becomes vₕ=aτₜₜ=(Qₕτₜₜ/m*)E where the quantity μₕ≡(Qₕτₜₜ/m*) is defined as hole mobility. μₕ.

Substituting mobility into the drift transport equation simplifies the relation for the average drift velocity of a hole to vₕ=μₕE. Combining the drift velocity vₕ expression with the drift current equation Jₕ=−Qₕvₕ to eliminate carrier velocity yields the expression Jₕ=−Qₕ(μₕE). Given the aforementioned definition of hole charge Qₕ=−qN_{A} the expression becomes Jₕ=−Qₕvₕ=(qN_{A})(μₕE)=(qN_{A}μₕ)E.

The parenthetical term is herein defined as conductivity σ=(qN_{A}μₕ) whereby Jₕ=I/A=σE. Given the definition of hole conductivity as σ=qμₕN_{A}, conductance is proportional to the multiplicative product of hole mobility μₕ, acceptor doping concentration N_{A}, and the elemental charge of a hole q which is identical to the charge on an electron. Using empirical data for hole mobility for degeneratively doped silicon at μₕ=55 cm²/Vs. Accordingly, conductivity a for degeneratively boron-doped P-type silicon is given by σ=qμₕN_{A}=(1.6×10⁻¹⁹ coul)(55 cm²/Vs)(4×10¹⁹ atoms/cm³)≈350 S/cm.

The transport and drift equations are not limited to hole conduction in P-type semiconductors but may be applied ionized molecules including hydrogen, where Q_{H+} denotes the quantity of ionized protons in a solid Q_{H+}=(qN_{H+}). In a PEM ionomeric membrane, the concentration N_{H+} is equivalent to the ionized acid groups resulting in immobile anions, whereby N_{H+}=α[A⁻]. In such cases J_{H+}=−(Q_{H+})(μ_{H+}E)=(qN_{H+})(μ_{H+}E)=(qN_{H+}μ_{H+})E. Defining hole conductivity as the parenthetical term σ=(qN_{H+}μ_{H+}) then J_{H+}=I/A=σE. Rearranging the conductivity equation as μ_{H+}=σ/(qN_{H+}), can be applied to empirically derive carrier mobility μ_{H+} of a proton exchange membrane from measured conductivity and calculated ionized acid concentration N_{H+}=α[A⁻]. The only uncertainty is the ionization constant α which is subject to empirical error.

Evaluated at a condition where α=20%, i.e. where one-fifth of the sulfonic acid groups are ionized, then allowing for their different total acid capacity TAC and corresponding molar ionic concentration Nᵢₒₙ, at λ=3.5 Nafion® 1100 exhibits an ion density of α[A⁻]=2.1438×10²⁰ ions/cm³ with a conductivity σ=8×10⁻³ S/cm. Applying the equation for effective mobility μ_{H+}=σ/(qN_{H+}) then Nafion® has an effective mobility μ_{H+}=(8×10⁻³ S/cm)/((1.6×10⁻¹⁹ coul)(2.1438×10²⁰ ions/cm³))=0.000233 cm²/Vs or in scientific notation as μ_{H+}=2.33×10⁻⁴ cm²/Vs.

Although hydration is required for fuel cell operation, excessive initial water can impair conduction. At λ=9.3, Nafion® 1100 is at 40% ionization with α[A⁻]=4.2877×10²⁰ ions/cm³ and σ=1.2×10⁻² S/cm corresponding to μ_{H+}=σ/(qN_{H+})=1.74×10⁻⁴ cm²/Vs. At even greater membrane hydration where λ=56 Nafion, σ=1.4×10⁻² S/cm, and μ_{H+}=σ/(qN_{H+})=1.02×10⁻⁴ cm²/Vs. The decline in mobility is largely due water logging impeding charge transport.

Similar calculations can be made using short sidechain PFSA membranes. Referring again to the table, at λ=5.35 and α=20%, Aquivion 720 has an ion density α[A⁻]=3.2778×10²⁰ ions/cm³ with conductivity σ=5×10⁻² S/cm with corresponding mobility given by μ_{H+}=σ/(qN_{H+})=(5×10⁻² S/cm)/((1.6×10⁻¹⁹ coul)(3.2778×10²⁰ ions/cm³))=0.000954 cm²/Vs or in scientific notation as μ_{H+}=9.54×10⁻⁴ cm²/Vs. At λ=14, ion density and conductivity increase to α[A⁻]=6.4556×10²⁰ ions/cm³ and σ=0.1 S/cm, whereby μ_{H+}=σ/(qN_{H+})=0.000968 cm²/Vs=9.68×10⁻⁴ cm²/Vs. In this SSC PFSA, the higher level of hydration increases carrier concentrations by 6.46/3.28=1.97× without degrading mobility. At higher hydration levels however, even short-sidechain low-EW PFSA membranes show degraded mobilities.

In this direct comparison, carrier mobility, not carrier concentration, is largely responsible for conductance differences among silicon, SSC PFSA, and LSC PFSA films with mobilities in the magnitudes 10⁺¹, 10⁻¹, and 10⁻² respectively. This large discrepancy cannot be explained by the mass difference between electrons and protons, but instead must be considered a consequence of effective mass. As derived previously, the effective mass of a charge is related to its mobility μ, charge q, and carrier transit time τ by the relation μ=Qτₜₜ/m* where m*, the effective mass of the transiting charge is inversely proportional to carrier mobility. Carrier mobility μ is the solid-state analog to mobility K for gasses defining a measure of friction linked the time τₜₜ ions take to traverse a defined ‘cell’ length.

While distance is difficult to define in gaseous systems, in solid material the transit time τₕ is more well defined by the average distance between ionomers. In particular the effective mass of a proton in a proton exchange membrane behaves as a larger mass to account for the ‘stickiness’ of the ionomers such as sulfonic acid which during conduction must first capture the proton then subsequently release it again as a hydrogen ion. This process invariable loses energy making the effective mass of the proton in a the exchange process appear more massive than its rest mass.

That said, studies suggest that the effective mass of a hydrogen ion (m_{H+})* is generally considered to be within the same order-of-magnitude of the mass of free hydrogen ions m_{H+}, i.e. within a factor-of-ten, but these are only guesstimates. If we consider the rest mass of a hydrogen atom to be m_{H+}=1.6726×10⁻²⁴ grams, then a rough estimate for the effective proton mass (m_{H+})*≈1×10⁻²³ grams. Unfortunately, direct measurement of the effective mass of hydrogen in transit in a heterogenous ionomeric polymer is difficult and subject to numerous experimental errors. A more accurate and self consistent calculation, employed in this application for the first time, employs a ratiometric comparison of proton mobility μ_{H+} to hole mobility μₕ.

Because silicon hole mobility and the effective mass of heavy holes, i.e. holes in heavily doped material, are precisely known experimental errors can be eliminated. Specifically the effective mass mₕ* of a heavy hole is approximately mₕ*=0.49m₀ where m₀=9.109×10⁻²⁸ g is the mass of a free electron. The effective mass of a heavy hole measured in grams is therefore mₕ*=0.49m₀=(0.49)(9.109×10⁻²⁸ g)=4.463×10⁻²⁸ g. The mobility of a hole in heavily doped material is approximately 55 cm²/Vs.

The mobility of long sidechain PFSA is 2.33×10⁻⁴ cm²/Vs, a factor 2.36×10 s times less mobile than hole mobility of 55 cm²/Vs. As such, the effective mass of a proton in Nafion® is m_{H+}*=(2.36×10⁵)mₕ*=(2.36×10⁵)(4.463×10⁻²⁸ g)=1.05×10⁻²² g. Compared to the rest mass of free hydrogen m_{H+}=1.6726×10⁻²⁴ g, the effective mass of the LSC proton is given by m_{H+}*=(1.05×10⁻²² g)/(1.6726×10⁻²⁴ g)=63(m_{H+}), sixty-three times more massive than a free hydrogen ion.

By contrast mobility of short sidechain PFSA is 9.68×10⁻⁴ cm²/Vs, a factor of (55 cm²/Vs)/(9.68×10⁻⁴ cm²/Vs)=5.68×10⁻⁴ heavier than a heavy hole. As such, the effective mass of a proton in Aquivion® is m_{H+}*=(5.68×10⁴)mₕ*=(5.68×10⁴)(4.463×10⁻²⁸ g)=2.53×10⁻²³ g. Compared to the rest mass of free hydrogen atoms m_{H+}=1.6726×10⁻²⁴ g, the effective mass of the LSC proton is given by m_{H+}*=(2.53×10⁻²³ g)/(1.6726×10⁻²⁴ g)=15(m_{H+}), fifteen times heavier than a hole.

As the dominant mechanism of charge conduction in an ionomeric polymer is that of diffusion and not of drift, the diffusion constant for ion transport is a key factor in describing current flow. According to Einstein, the diffusivity of a charge carrier is inextricably linked to its mobility by the thermodynamic mechanism of Brownian motion and thermal vibration as quantified by the thermal voltage k_{B}T/q according to the Einstein relation

$$\frac{D}{μ} = \frac{{k}_{B} T}{q} = {V}_{θ}$$

where D is diffusivity, μ is carrier mobility, k_{B} is Boltzmann's constant, T is temperature, q is the elemental charge of an proton or electron, and V_{θ} is the thermal voltage equal to 25.69 mV at 25° C. and 82.21 mV at 80° C. Given proton mobility from above, proton diffusivity is found by evaluating the expression D_{H+}=(μ_{H+})(V_{θ}). For LSC at 25° C., D_{H+}=(2.33×10⁻⁴ cm²/Vs)(0.02560 V)=6.0×10⁻⁶ cm²/s while at 80° C., proton diffusivity is increased because of a higher thermal voltage having a value D_{H+}=1.9×10⁻⁵ cm²/s. For SSC at 25° C., D_{H+}=(9.68×10⁻⁴ cm²/Vs)(0.02560 V)=2.5×10⁻⁵ cm²/s while at 80° C. diffusivity is D_{H+}=7.9×10⁻⁵ cm²/s.

Unlike P-type silicon whose hole diffusivity depends on semiconductor bandgap and boron's acceptor energy level above the valence band, proton diffusivity in a PEM depends primarily on the polymer membrane's chemistry, stoichiometry, and film hydration. A wide range of diffusivities have been reported for Nafion® and other PFSA membranes using NMR diffusion studies of proton-exchange membranes summarized in the table below. The table includes various reported IEMs and equivalent weights at differing hydration levels. The diffusivity values are directly measure using nuclear magnetic resonance (NMR). The mobility values are calculated from the Einstein relation μ_{H+}=D/V_{θ} where V_{θ}(25° C.)=25.69 mV and V_{θ}(80° C.)=82.21 mV.

| | Equiv weight | Hydration | Energy | 25° C. Diffusivity | Mobility (cm²/Vs) | |
|---|---|---|---|---|---|---|
| | symbol (units) | | | | | |
| Material | EW (g/eq) | λ | Eₐ (eV) | D₀ (cm²/s) | μ_{H+} (25° C.) | μ_{H+} (80° C.) |
| F 950 | 950 | 1.5 | 0.32 | 7.7 × 10⁻⁶ | 3.00 × 10⁻⁴ | 9.60 × 10⁻⁴ |
| FS 930 RFS | 930 | 1.4 | 0.31 | 8.1 × 10⁻⁶ | 3.15 × 10⁻⁴ | 3.00 × 10⁻⁴ |
| Nafion ® 117 | 1100 | 2.6 | 0.25 | 1.1 × 10⁻² | 4.28 × 10⁻¹ | 4.28 × 10⁻¹ |
| Nafion ® 212 | 1100 | 6.4 | 0.23 | 8.0 × 10⁻³ | 3.11 × 10⁻¹ | 3.11 × 10⁻¹ |
| Nafion ® 211 | 1100 | 6.6 | 0.24 | 1.2 × 10⁻² | 4.67 × 10⁻¹ | 4.67 × 10⁻¹ |
| Nafion ® 117 | 1100 | 6.7 | 0.22 | 7.8 × 10⁻³ | 3.04 × 10⁻¹ | 3.04 × 10⁻¹ |
| F 950 | 950 | 8.3 | 0.20 | 4.7 × 10⁻³ | 1.82 × 10⁻¹ | 1.82 × 10⁻¹ |
| FS 930 RFS | 930 | 8.6 | 0.22 | 1.4 × 10⁻² | 5.45 × 10⁻¹ | 5.45 × 10⁻¹ |

During charge transport through an ionomeric membrane, both drift and diffusion current are present. Unlike drift current which relies on electric field force to propel a charge by electrostatic force, diffusion current depends only on a concentration gradient dN/dx and charge diffusivity D to produce electric current, as described by Fick's First Law for diffusion stating

$${J}_{diff} = \frac{I}{A} = qD = \frac{dN}{dx}$$

where for an ion exchange membrane dN_{H+}/dx is the concentration gradient of hydrogen present across the polymeric membrane. The differential dN is defined as dN=N_{ACL}−N_{CCL} where N_{ACL} is the generated proton concentration in the anode catalyst layer (ACL) and N_{CCL} is the proton concentration in the cathode catalyst layer (CCL), the difference dN/dx comprising the carrier gradient across the membrane of effective thickness dx.

While the injected charge is in fact added to the resident charge from the ionized acids, the immobile anions and ionized protons are charge neutral and in the absence of charge injection or electric fields do not conduct electricity or generate energy.

Assuming the oxygen reduction reaction (ORR) at in the CCL converts 100% of the incoming hydrogen ions into water, the proton concentration at the membrane-to-CCL interface is zero, i.e. [H+]_{CCL}=0. As such, dN=N_{ACL} the carrier concentration [H+]_{ACL} generated by catalysis of incoming hydrogen fuel. Assuming a 20-μm thick membrane, dx=20×10⁻⁴ cm then at 25° C., N_{ACL}=dN=Jdx/qD=(0.25 A/cm²)(20×10⁻⁴ cm)/((1.6×10⁻¹⁹ coul)(6.0×10⁻⁶ cm²/s))=5.2×10²⁰ ions/cm³ for LSC PFSA.

The corresponding LSC ion gradient is dN/dx=(5.2×10²⁰ ions/cm³)/(20×10⁻⁴ cm)=2.6×10²³ ions/cm⁴. The added charge defined as ΔQ⁺=5.2×10²⁰ ions/cm³ is approximately 2.5 times the ionized ionomer concentration of N_{H+}≈2.1438×10²⁰ ions/cm³.

In the case of a SSC PFSA where D=2.5×10⁻⁵ cm²/s, then N_{ACL}=dN=Jdx/qD=(0.25 A/cm²)(20×10⁻⁴ cm)/((1.6×10-19 coul)(2.5×10⁻⁵ cm²/s))=1.25×10²⁰ ions/cm³. At ΔQ⁺=1.25×10²⁰ ions/cm³ this injected charge is roughly half the ionized ionomer concentration of N_{H+}≈N_{H+}≈3.2778×10²⁰ ions/cm³. The corresponding SSC ion gradient is dN/dx=(1.25×10²⁰ ions/cm³)/(20×10⁴ cm)=6.25×10²² ions/cm⁴. Compared to long sidechain PFSA, SSC is able to conduct more current with less extra charge because of its higher conductivity, higher mobility, and lower effective mass.

A summary of material properties for ionomeric conduction in PFSA is contrasted to that of P-type silicon, an apropos comparison as both involve conduction through the successive binding and release of positive charges. Using the diffusion equation, the described membrane conducts current densities of J=0.25 A/cm². To convert current density (A/cm²) into current (A) as per the relation I=JA it is necessary to determine the appropriate estimate of conducting area A. As detailed previously, charge hopping conduction involves the transfer of protons (or other charge carriers) from one fixed site to another. This is facilitated by the presence of immobile anions such as sulfonic acid groups in PFSA membranes or other acids in hydrocarbon based IEMs. This type of conduction is primarily driven by a concentration gradient of mobile hydrogen ions.

| | P-type | | | |
|---|---|---|---|---|
| Property | Silicon | PFSA | | Units |
| structural | silicon | PTFE | PTFE | — |
| support | crystal | | | |
| charge | ionized | LSC sulfonic | SSC sulfonic | — |
| source | boron | anion | anion | |
| density ρ | 2.3 | 2.0 | 2.0 | g/cm³ |
| charge | N_{A} ≤ | N_{H+} ≈ | N_{H+} ≈ | cm⁻³ |
| density | 4 × 10¹⁹ | 2.1438 × 10²⁰ | 3.2778 × 10²⁰ | |
| effective | 0.49m₀ | 63m_{H+} | 15m_{H+} | — |
| mass m* | | | | |
| conductivity | 360 | 8 × 10⁻³ | 5 × 10⁻² | S/cm |
| σ | | | | |
| mobility μ | μₕ = 55 | μ_{H+} = 2.33 × 10⁻⁴ | μ_{H+} = 9.68 × 10⁻⁴ | cm²/Vs |
| diffusivity | Dₕ = 1.4 | D_{H+} = 6.0 × 10⁻⁶ | D_{H+} = 2.5 × 10⁻⁵ | cm²/s |
| D (25° C.) | | | | |
| diffusivity | Dₕ = 4.5 | D_{H+} = 1.9 × 10⁻⁵ | D_{H+} = 7.9 × 10⁻⁵ | cm²/s |
| D (80° C.) | | | | |
| tortuosity | 1 | 3 | 3 | — |
| factor δ | | | | |
| peak ion | p = | ΔQ⁺ = 5.2 × 10²⁰ | ΔQ⁺ = | cm⁻³ |
| concentration | 4 × 10¹⁹ | | 1.25 × 10²⁰ | |

Since ionomers such as sulfonic acid groups comprise immobile anions spread throughout the membrane, charge hopping (Grotthuss) conduction occurs from one acid releasing a proton which diffuses to the nearest unoccupied immobile anion only to be captured and re-released into the matrix. The residence time of the proton staying attached to an un-ionized acid varies from durations of picoseconds (10⁻¹² seconds) to nanoseconds (10⁻⁹ seconds) depending on membrane hydration, temperature, and the polymer's molecular structure and crystallinity. Because of its small atomic size, hydrogen ions can penetrate in all directions throughout the polymeric matrix flowing from high concentration areas to lower. So long that a slight pressure and convective flow delivers a steady supply of hydrogen to the anode catalyst layer (ACL) then the interfacial proton concentration ΔQ⁺ is maintained at a concentration higher than the ionized anion concentration. Excess charge ranges from 15% to 1000%, i.e. 100×. This means the dominant driving force for charge hopping conduction in a ionomeric membrane is diffusion.

Given that immobile anions are uniformly distributed and hydrogen ions can diffuse through the entire cross-sectional area, diffusion based charge hopping results is uniform current conduction across the IEM. As such, describing diffusion current by the current density parameter J accurately represents conduction current in any size membrane. In other words, the applicable area for calculating diffusion current in an IEM is the full active area of a fuel cell A_{FC}.

For example, if the diffusion current density in a PFSA membrane is J=250 mA/cm² then the calculated current for a membrane of area A_{FC}=1 cm², the resulting current I=JA_{FC}=(250 mA/cm²)(1 cm²)=250 mA. If the area is 200 times greater, i.e. A_{FC}=200 cm² then the current is also 200× greater, where I=JA_{FC}=(250 mA/cm²)(200 cm²)=50 A, a very realistic magnitude of current useful in power and energy applications.

Comparing diffusive charge hopping to vehicular transport reveals a dramatic difference. Vehicular transport involves the movement of ions or molecules that carry the charge, such as hydrated protons (H₃O⁺) or other ion clusters to move through the membrane by physically migrating along pathways or channels. For vehicular transport, a matrix of micropores and nanopores must form a contiguous interconnected patchwork of interconnected tunnels to carry water and conduct hydronium ions. In the absence of these channels, vehicular transport cannot provide interstitial conduction. To determine the relative contributions of diffusion and drift mechanisms in vehicular transport several parameters must be determined namely (i) the length dx of the conduction path; (ii) the concentration gradient dN/dx over that path; (iii) the average cross sectional area of the conducting channels; and (iv) the average electric field dV/dx along the path, and (iv) the physical constants of mobility μ_{H+} and diffusivity D_{H+} for proton conduction in specific ionomeric films.

Three of these calculations depend on the length of the vehicular conduction path. This length dx is not the membrane thickness X_{IEM} but is significantly longer accounting for the tortuous path length of the conductive channels weaving their way through the polymer matrix. A longer path length dx lowers dN/dx reducing vehicular diffusion current, and also lowers the electric field dV/dx reducing vehicular drift current. A tortuous multiplicative factor of δ=2.5 to δ=3.0 times the membrane thickness is a reasonable estimate based on various studies. Accordingly, the path length for vehicular transport is dx=δX_{IEM}. For example, a X_{IEM}=20 μm film with δ=3.0, dx=δX_{IEM}=3(20 μm)=60 μm. For a LSC membrane concentration gradient of 2.6×10²³ ions/cm⁴ and a diffusivity of 6.0×10⁻⁶ cm²/s, the corresponding LSC diffusion current density is J_{diff}=qD(dN/dx)=250 A/cm².

Although the diffusion component of vehicular transport depends on the concentration gradient dN/dx, the drift component of vehicular transport relies on electrostatic force as a function of the electric field E=dV/dx. Given the cell voltage developed across a single CCM later is approximately dV=700 mV and assuming a membrane thickness of X_{IEM}=20 m film with a tortuosity factor δ=3.0, then dx=δX_{IEM}=3(20 μm)=60 μm. Given E=dV/dx then the electric field E=0.7V/(60×10⁻⁴ cm)=116 V/cm.

From the drift current equation J_{dr}=qμ_{H+}N_{H+}E=(1.6×10⁻¹⁹ coul)(2.33×10⁻⁴ cm²/Vs)(2.1438×10²⁰ coul/cm²)(116 V/cm)=(8×10⁻³ S/cm)(116 V/cm)=928 mA/cm². Given a conductivity of σ=8×10⁻³ S/cm from the foregoing, the drift current density J_{dr} in conducting micropore channels is given by J_{dr}=σE=(8×10⁻³ S/cm)(116 V/cm)=0.928 A/cm²=928 mA/cm², a current 3.7× greater than the vehicular diffusion current of 250 mA/cm².

Together, total vehicular current Jᵥ comprising both drift and diffusion components sum to Jᵥ=J_{diff+}J_{dr}=(250 A/cm²)+(928 mA/cm²)=1178 mA/cm² of which 21% is diffusion and 79% is drift. Although the current density is high, the total current contribution of vehicular transport is a relatively small fraction of total IEM current. The reason for diminutive contribution is because of the small cross sectional area of the conducting channels and their relatively low density. Assuming a cross sectional area of a micropore (μp) to be Aᵤₚ=100 nm² per pore, the total vehicular current carried by any one channel is approximately Jᵥ A_{μp}=(0.1178 A/cm²)(1 cm²/10¹⁴ nm²)(100 nm²)=0.1178×10⁻¹² A or 12 pA/channel. Removing dead end channels, the total density of conducting micropores in a reference fuel cell of area A_{FC}=1 cm² area of pristine PFSA is estimated to be approximately ρ_{μp}=A_{μp}/A_{FC}=5%. The total current contribution of vehicular conduction current is therefore Jᵥρ_{μp} A_{FC}=(0.1178 A/cm²)(5%)(1 cm²)=5.9 mA/cm², only 2.4% of the total membrane current.

In summary, charge hopping current in a conventional ionomeric membrane is dominated by diffusion current with virtually no drift current contribution. Vehicular transport in pristine membranes contributes less than 5% of total current due to the limitation of tortuous conduction further constrained by low microporous channel densities and small cross sectional areas of conducting polymeric conduits. Further limitations of conventional ionomeric membranes includes a propensity of short sidechain (SSC) membrane to swell excessively with hydration and suffer water logging further adversely impacting conduction and IEM performance.

To offset the inherent deficiencies as identified here, an improved ionomeric membranes made in accordance with this invention includes
physically constraining the ionomeric membrane with an endoskeletal matrix designed to reduce physical deformation of ionomeric membranes during manufacturing and in operation, especially for higher conductivity polymers with a propensity for water logging like short sidechain PFSA;
enhancing the density of contiguous microporous channels through the use of sacrificial fillers to enhance vehicular conduction improving current density and conductivity while reducing conduction losses;
expanding the cross sectional area of micropores through the use of sacrificial fillers to enhance vehicular conduction improving current density and conductivity while reducing conduction losses;
reducing tortuosity of microporous channels by eliminating dead end channels through the use of sacrificial fillers enhancing vehicular conduction, improving current density, and boosting conductivity while reducing conduction losses;
reducing the mean free path, transit time, and effective mass of protons traversing the molecular matrix through the introduction of permanent fillers comprising ionomeric crystals, organic, metal organic, and other charge transfer compounds not bound to the polymeric matrix; and
enhancing the mobile charge concentration in the membrane through membrane doping with ionic liquids, where the ionic liquids are contained by endoskeletal support and membrane nano-coatings to prevent seepage and IL leakage.

These innovations improve overall membrane conductivity by enhancing vehicular transport without damaging membrane integrity or disrupting the efficiency of charge hopping conduction.

### Charge & Mass Conservation.

Referring again to the equation

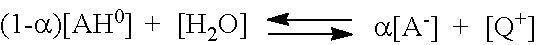

where the hydration factor λ also known as water uptake is defined as the ratio of water concentration [H₂O] and

$$λ ≡ \frac{[ {H}_{2} O ]}{[ {A}^{-} ]} = \frac{[ {H}_{2} O ]}{[ {HA}^{0} ]}$$

the term on the left side of the equation [(1−α)[AH⁰] describes the quantity of ionomeric groups comprising unionized acids and where [AH⁰]≡m(AH⁰). The term on the right α[A⁻]+Q⁺ describes the quantity of immobile and mobile charges present in the film where the concentration [A⁻] is equal to m[A⁻]. In the absence of current flow through the membrane, any net change of charge present in the film must sum to zero, i.e. Σq=0.

Accordingly, charge balance requires that the total positive charge Q⁺ created by deprotonation of the polymeric acid forming anions α[A⁻] must precisely balance the number of mobile protons Q*=α[H⁺] released. As such, the magnitude of charges |q| must balance whereby |Q⁺|=|α[H⁺]|=|αm(A⁻)| meaning every liberated proton (H⁺) leaves an immobile anionic ionomer (A⁻) behind. The number of free protons released, however, does not remain constant. In aqueous solutions when the membrane is hydrated, hydrogen atoms coming in contact with water molecules spontaneously and rapidly convert into hydronium ions H₃O⁺, meaning the total mobile charge quantity Q⁺ is necessarily split between hydronium ions H₃O⁺ and free hydrogen ions H⁺.

Assuming a resulting charge ratio β between hydronium ions βH₃O⁺ and unconverted hydrogen ions (1−β)H⁺ then the total mobile charge Q⁺ can be expressed by in terms of electrostatic charge neutrality as

$${0}^{+} = α ( 1 - β ) [ {H}^{+} ] + α β [ {H}_{3} {O}^{+} ]$$

or chemically in terms of an equilibrium reaction as

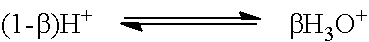

The value of β depends, not only the conversion of aqueous hydrogen into hydronium as measured by pH but also by the hydration of the ionomeric polymer. In cases of high hydration, the value of β→1 meaning all the hydrogen is converted into hydronium ions. Because nearly 100% of free hydrogen coming in contact with water spontaneously and instantaneously forms hydronium, the value of β is not a measure of hydronium conversion rates but of the fraction of ionized hydrogen in proximity to water.

While in solution, the dissociation of water into hydrogen and hydroxide and the subsequent nearly total conversion into hydronium means for all practical purposes in aqueous solutions, the concentrations [H⁺]=[H₃O⁺] and the terms hydrogen can be used interchangeably in the calculation of acidity and in calculating the ‘power of hydrogen’ commonly referred to as pH. In a ionomeric membrane at low hydration levels however, hydrogen ions [H⁺] can exist and persist without ever coming in contact with water molecules.

As such, in the foregoing equation Q⁺=α(1−β)[H⁺]+αβ[H₃O⁺] the term α(1−β)[H⁺] represents anhydrous hydrogen while αβ[H₃O⁺] represents hydrated hydrogen (H⁺·H₂O). Since the term pH has no meaning for gaseous hydrogen atoms or ions, then only water complexed hydrogen αβ[H₃O⁺] determines the pH of the solution present inside the channels of aqueous ion exchange membranes. Defining aqueous pH by the relation [H₃O⁺]=10^{(-pH)}

then as a function of hydronium concentration in water, pH is given by the equation

$$pH = - {log}_{10} [ {H}_{3} {O}^{+} ]$$

Adapting the concept of pH for an ionomeric membrane, the membrane pH is equal to

$$pH = - {log}_{10} \{ αβ [ {H}_{3} {O}^{+} ] ) = f \{ λ )$$

where α is the ionization constant for the acid, β is the fraction of hydrogen ions converted into hydronium, and k is the hydration factor. For example, assuming a Nafion® 1100 film with α=20% and N_{H+}≈2.1438×10²⁰ then the effective pH of the membrane depends on the hydronium fraction β as follows: As shown the effective pH of a PFSA membrane is quite low attributable to the small pKₐ≤+0.754 and high dissociation constant for sulfonic acid.

Continuing with reaction stoichiometry, substituting the value of [Q⁺] into the reaction equation yields the mass-charge conserved expression

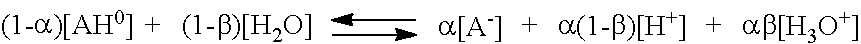

where the multiplicative term (1−β) is used to adjust the un-ionized water concentration (1−β)[H₂O] and the unconverted free hydrogen concentration α(1−β)[H⁺]. Made in accordance with conservation principles the equilibrium reaction β[H₃O⁺]⇄(1−β)[H⁺]+(1−β)[H₂O] describes that for every β hydronium ions formed the free hydrogen ion and unreacted water concentration are reduced by a factor of (1−β). The hydronium term may also be expressed in pH as αβ[H₃O⁺]=10^{(-pH)}

| | | Ion | [H₃O⁺] | |
|---|---|---|---|---|
| Material | Ionization α | Density N_{H+} | Conversion β | Effective pH |
| Nafion ® | 20% | 0.2356 | 1% | 2.63 |
| 1100 | | moles/cm³ | 2% | 2.33 |
| | | 2.142 × 10²⁰ | 5% | 1.82 |
| | | ions/cm³ | 10% | 1.63 |
| | | | 20% | 1.32 |
| | | | 30% | 1.15 |
| | | | 40% | 1.03 |
| | | | 50% | 0.93 |
| | | | 60% | 0.85 |
| | | | 70% | 0.78 |
| | | | 80% | 0.73 |
| | | | 90% | 0.67 |
| | | | 100% | 0.63 |

Since the foregoing reactions are bidirectional as indicated by the mirrored arrows symbol ⇄, then in equilibrium neutral acids convert to mobile charge of protons [H⁺] and hydronium ions [H₃O⁺] while at an equal opposite rate the mobile charges de-ionize back into charge neutral acids [AH⁰]. Concurrently in equilibrium a portion of newly released protons [H⁺] spontaneously convert into hydronium ions [H₃O⁺] while concurrently an equal number of hydronium ions H₃O⁺ revert into mobile proton H⁺ cations. The relative ratios of the three components are determined by statistical mechanics and thermodynamics as embodied in the acid ionization constant α and the hydronium autoionization ratio β. The values of α and β remain constant for a given membrane chemistry maintained at a fixed temperature, pressure, and humidity.

### Ionomeric Conduction.

In fuel cell operation, the reaction equation for the membrane electrochemistry is perturbed by the continuous supply of new charge in the form of ionized hydrogen fuel entering the membrane from the anode terminal and eventually departing the cathode. Including the influx in charge ΔQ⁺ the steady state equation during fuel cell operation and electric power generation is then

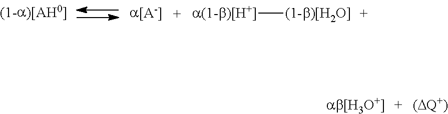

The incremental charge ΔQ⁺ comprises the hydrogen ion fuel ingress at the anode and egress at the cathode feeding an oxygen reduction reaction (ORR) occurring in the cathode catalyst layer (CCL) and η is the energy conversion efficiency of the ORR consuming hydrogen ions and oxygen to produce electricity and water as a waste product. Specifically, cations ΔQ⁺ transported across the membrane reaching the cathode, are converted into water according to the ORR reaction equation

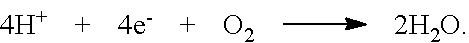

Defining the term ΔQ⁺ as the net change in charge and mass during operation then ΔQ*=−φ_{H+}+dq+Q_{diff}−Φ_{O2}+Φ_{H2O} where D denotes material flux including hydrogen fuel in −Φ_{H+}=dN_{H+}, oxygen reducing agent in −Φ_{O2}=dN_{O2}, and net water Φ_{H2O} comprising generated water G[H₂O] less water R[H₂O] removed by draining. Substituting the foregoing yields the relation

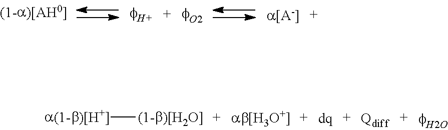

Applying the ORR water reaction Φ_{H2O}=G[H₂O]−R[H₂O] and combining water terms yields the closed loop equation

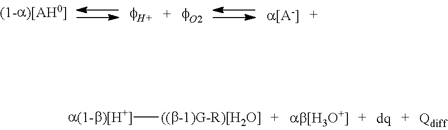

A key element of this expression is that generated water G[H₂O] offset by any water removed from drainage R[H₂O] is the source of water (1−β)[H₂O] used to form hydronium β[H₃O⁺] and is also the source of water used to facilitate ionization of the acid groups into immobile anions α[A⁻]. In other words, once the fuel cell commences operation it generates its own water needed to support the reaction. Taking the time derivative of the foregoing equation in steady state operation yields the simplified expression

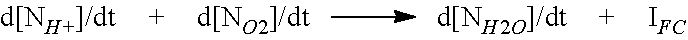

where I_{FC}=(dq/dt)+C_{FC}(dV/dt). This equation means so long that hydrogen and oxygen are supplied, the fuel cell will produce electric current and waste water. It should be noted that in steady state ΔQ⁺ is equal to zero, meaning whilst the fuel cell is operating, the hydrogen fuel and oxygen ingress balance the water and electrical outputs in both mass and charge. To sustain steady state conduction, a constant supply of charge dq must be maintained by corresponding continuous supply of hydrogen fuel labelled here as incoming flux −Φ_{H+}=dN_{H+}.

Before the steady state condition is reached, however, the concentration gradient must be established, a process akin to charging diffusion capacitance, named here as C_{FC} where C_{FC}=Q_{diff}dV. Diffusion charge Q_{diff} is the concentration gradient times membrane thickness as given by Q_{diff}=(dN_{H+}/dx)X_{IEM}, which in the case of a 20 μm thick Nafion® 1100 is given by Q_{diff}=(2.6×10²³ ions/cm⁴)(20×10⁻⁴ cm)=5.2×10²⁰ ions/cm³=83.2 coulombs=23 mAh. This energy is equal to 83 A-see or 1.4 A-min, meaning it takes nearly a minute and a half to clear the stored charge in the membrane. Assuming V_{FC}=0.7V, the diffusion capacitance is 58 farads.

Once the capacitor is charged and the fuel cell voltage stabilizes then dV/dt=0 and the displacement current component disappears until operation is terminated. Upon cessation of operation, the stored charge in the membrane must dissipate before conduction ceases. Since no significant recombination mechanisms exist, charge depletion requires excess charge to diffuse out of the ionomeric matrix.

### Immobile Anionic Homo-Ionomers for PEMs.

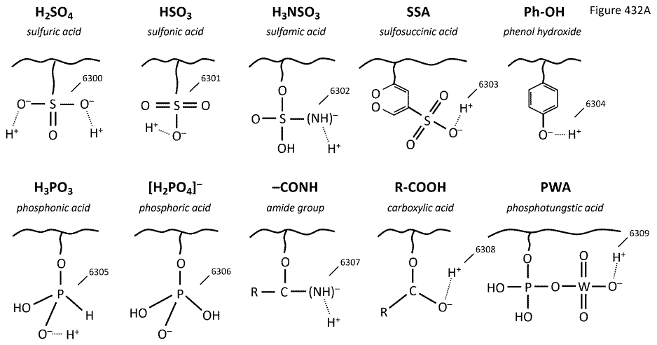

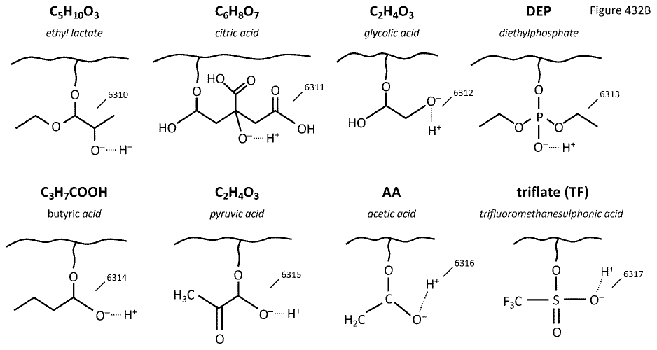

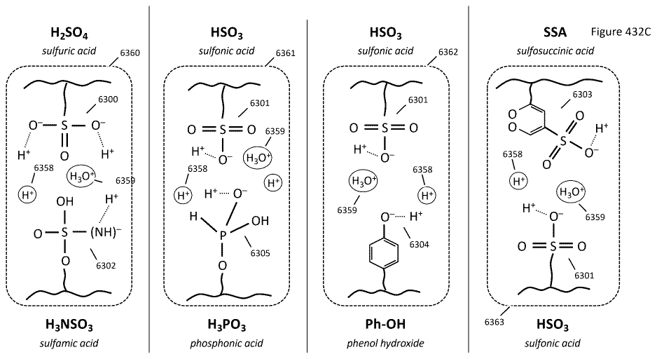

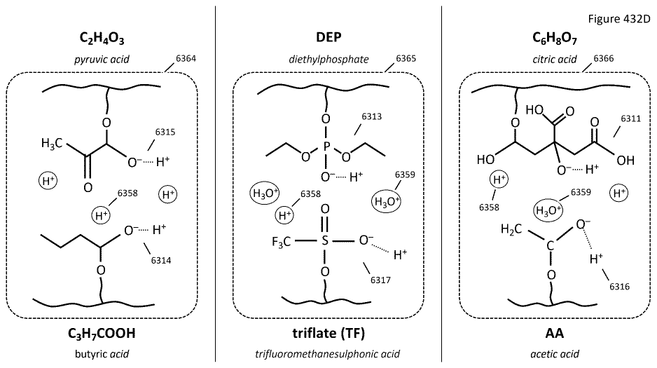

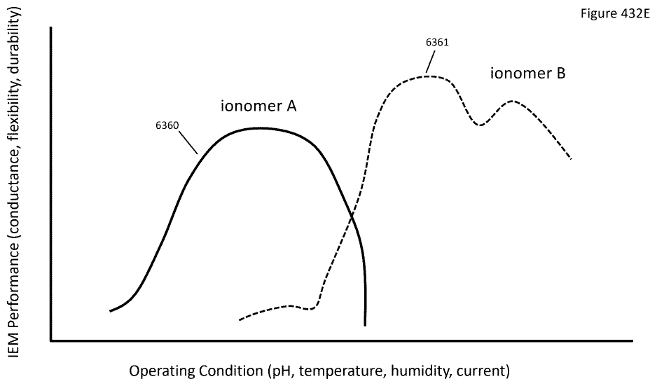

A number of acids compatible with ionomers made in accordance with this invention are described herein as illustrated in FIG. 432A and FIG. 432B. In the drawings shown, each ionomer's name identifies its neutral origin while the chemical representation illustrates its ionized anionic form along with a schematic representation of pedant sidechain attached to a polymer backbone. The polymeric spine may comprise any of the aforementioned polymers described previously FIG. 430 and various examples of FIG. 431 including those films comprising homopolymers, fluorocarbon di-monomers, hydrocarbon di-monomers, hydrocarbon multi-polymers, hydrocarbon and fluorocarbon copolymers, hydrocarbon hybrid heteropolymers, anhydrous polymers and biopolymers, and block polymers.

### Sulfuric Acid:

Applicable acids as shown by example in FIG. 432A include sulfuric acid (H₂SO₄), pKₐ=−3, converted into a divalent anionic ionomer sulfate (SO₄)²⁻ 6300 by the simplified reaction

(H₂SO₄)⇄(SO₄)⁻²⁺H⁺⁺H₃O⁺

In operation, the concentration of protonated and deprotonated ionomer termini reach an equilibrium condition between the neutral acids (H₂SO₄); immobile sulfate anions (SO₄)⁻²; and mobile cations H⁺ and H₃O⁺ (not shown). A more complete description as discussed previously includes hydration resulting from the cathode catalyst layer (CCL) providing a transport medium from ions in aqueous fuel cells. For brevity's sake the role of water is excluded from the equation as shown. As such, the equations are illustrative and not intended to conserve charge or mass. For example, in the divalent ionization shown, two hydrogen ions 2H⁺ are released into solution, not one as indicated. But since water is excluded from the equation and hydronium ions include excess protons in varying concentrations and quantities no insight by detailed accounting of hydrogen and water molecules.

To further complicate matters sulfuric acid (H₂SO₄) may also be converted into a monovalent anionic ionomer hydrogen sulfate (HSO₄)⁻ (not shown) by the simplified reaction (H₂SO₄)⇄(HSO₄)⁻+H⁺+H₃O⁺. And since the reaction kinetics for monovalent and divalent deprotonation are similar, it is more likely in fuel cell operation both monovalent and divalent immobile anions are present concurrently in which case, the simplified reaction equation becomes

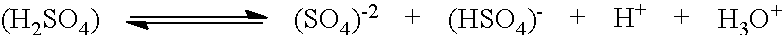

again where the equation is neither mass or charge balanced. Made in accordance with this invention, homo-ionomeric ion exchange membranes compatible with sulfuric acid and immobile anion derivatives therefrom include the following polymers: perfluorosulfonic acid (PFSA) polymer such as Nafion; polybenzimidazole (PBI); sulfonated poly(ether-ether ketone) (SPEEK); sulfonated poly(phenylene oxide) (SPPO); sulfonated polyimides (SPI); sulfonated poly(arylene ether sulfone) (SPAES); and poly(vinylidene fluoride) (PVDF) blended with sulfonated polymers; and others without limitation. These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Sulfonic Acid:

In a similar manner, sulfonic acid (HSO₃) is converted into the monovalent anionic ionomer (SO₃)⁻ 6301 called sulfonate by the reaction

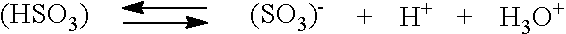

Although the pKₐ of sulfonic acid ranges from −2 to 0 or possibly to +0.5 in solution, sulfonic acid groups attached to polymers typically exhibit reduced acidity at pKₐ=+0.754, likely because of electrostatic and hydrophobic influence of adjacent polymer backbones.

Made in accordance with this invention, homo-ionomeric ion exchange membranes compatible with sulfonic acid and immobile derivatives therefrom include the following polymers: perfluorosulfonic acid (PFSA) polymer such as Nafion; sulfonated poly(ether-ether ketone) (SPEEK); sulfonated poly(phenylene oxide) (SPPO); sulfonated polyimides (SPI); sulfonated poly(arylene ether sulfone) (SPAES); poly(styrene sulfonic acid) (PSSA); poly(vinylidene fluoride) (PVDF) blended with sulfonated polymers; and others without limitation. These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Sulfamic Acid:

Another sulfur-based compound, sulfamic acid (H₃NSO₃), pKₐ=+1, is converted into the monovalent anionic ionomer (H₂NSO₃)⁻ 6302 as per the equilibrium reaction

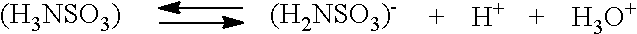

where ionization of the sulfamic acid produces a monovalent immobile anion (H₂NSO₃)⁻ called sulfamate. Made in accordance with this invention, homo-ionomeric ion exchange membranes compatible with sulfamic acid and immobile anion derivatives therefrom include the following polymers: perfluorosulfonic acid (PFSA) polymer such as Nafion; sulfonated poly(ether-ether ketone) (SPEEK); sulfonated poly(phenylene oxide) (SPPO); sulfonated polyimides (SPI); sulfonated poly(arylene ether sulfone) (SPAES); sulfonated poly(arylene ether ketone) (SPAEK); poly(vinylidene fluoride) (PVDF) blended with sulfonated polymers; and others without limitation.

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Sulfosuccinic Acid:

In the equilibrium reaction of sulfosuccinic acid: (SSA), pKₐ=+1.5, having the chemical composition (C₄H₆O₇S) given by

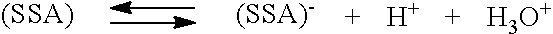

sulfosuccinic acid is converted into monovalent anionic ionomer (SSA)⁻ 6303 called sulfosuccinate having the formula (C₄H₅O₇S)⁻ by deprotonation of an OH group. Made in accordance with this invention, homo-ionomeric ion exchange membranes compatible with sulfosuccinic acid and immobile anion derivatives therefrom include the following polymers: perfluorosulfonic acid (PFSA) polymer such as Nafion; sulfonated poly(ether-ether ketone) (SPEEK); sulfonated poly(phenylene oxide) (SPPO); sulfonated polyimides (SPI); sulfonated poly(arylene ether sulfone) (SPAES); sulfonated poly(arylene ether ketone) (SPAEK); poly(vinylidene fluoride) (PVDF) blended with sulfonated polymers; and others without limitation.

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Phenol Hydroxide:

Phenyl comprising a aromatic benzene ring (C₆H₆) in which a hydrogen atom has been replaced with am atom or functional group has the general form (C₆H₅R). In the special case where the hydrogen is replaced with a hydroxyl group (R═OH) the resulting cyclic compound (C₆H₅OH) is referred to as ‘phenol,’ i.e. oxygenated phenyl. Since phenyl has the pseudoatomic abbreviation Ph, then the hydroxide variant is commonly referred to by the nomenclature (PhOH) as phenol hydroxide.

Deprotonating the hydroxide group results in the anion (PhO)⁻ having a chemical formula (C₆H₅O)⁻ called phenolate. With a pKₐ=+10, phenol hydroxide comprises a relatively weak acid. In the case of a ionomeric membrane, phenol hydroxide is converted into phenolate, a monovalent anionic ionomer (PhO)⁻ 6304 through a process of ionization of the hydroxide group made in accordance with the equilibrium reaction

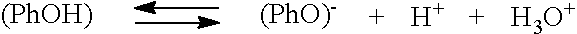

Made in accordance with this invention, homo-ionomeric ion exchange membranes compatible with phenol hydroxide acid and immobile derivatives therefrom include the following polymers: polybenzimidazole (PBI); functionalized poly(vinyl alcohol) (PVA) with crosslinking agents; functionalized poly(phenylene oxide) (PPO); functionalized poly(ether-ether ketone) (PEEK); functionalized poly(ethylene oxide) (PEO); functionalized polyimides (PI); functionalized polysulfone (PSU); and others without limitation.

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Phosphonic Acid.

Another acid capable of forming ionomers in PEM membranes includes phosphonic acid (H₃PO₃), pKₐ=+1.3, converted into monovalent anionic ionomer dihydrogenphosphite (H₂PO₃)⁻ 6305 by the equilibrium reaction

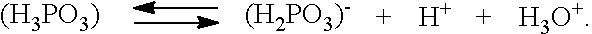

Made in accordance with this invention, homo-ionomeric ion exchange membranes compatible with phosphonic acid and immobile derivatives therefrom include the following polymers: perfluorosulfonic acid (PFSA) polymer such as Nafion; polybenzimidazole (PBI); poly(vinyl alcohol) (PVA) with phosphonic acid groups; poly(ether-ether ketone) (PEEK) with phosphonic acid groups; poly(ethylene oxide) (PEO) with phosphonic acid groups; polyimides with phosphonic acid groups; polysulfone (PSU) with phosphonic acid groups; and others without limitation.

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Phosphoric Acid.

Phosphoric acid (H₃PO₄) is a medium strength triprotic acid capable of ionizing into multiple valence states. Single proton ionization results in the monovalent anion (H₂PO₄)⁻ referred to dihydrogen phosphate. The ionization of two hydrogens into solution produces the divalent anion hydrogen phosphate (HPO₄)⁻². Complete deprotonation of all hydrogen atoms produces the trivalent phosphate anion (PO₄)⁻³. The respective pKₐ values for the single, double, and triple ionized variants are pKₐ values of 2.15, 7.2, and 12.4.

As such, only the singularly ionized moiety dihydrogen phosphate (H₂PO₄)⁻ is relevant to phosphoric acid based ionomers whereby the equilibrium reaction

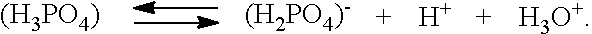

produces the immobile anion dihydrogen phosphate (H₂PO₄)⁻ 6306. Made in accordance with this invention, homo-ionomeric ion exchange membranes compatible with phosphoric acid and immobile derivatives therefrom include the following polymers: polybenzimidazole (PBI); poly(vinyl alcohol) (PVA) with phosphoric acid groups; poly(ether-ether ketone) (PEEK) with phosphoric acid groups; poly(ethylene oxide) (PEO) with phosphoric acid groups polyimides with phosphoric acid groups; polysulfone (PSU) with phosphoric acid groups; and others without limitation, including polytetrafluoroethylene (PTFE).

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Amide Conjugate Acids.

In some instances an acid auto ionizes into a charged radical by removal of a proton during formation. One example includes the amide conjugate acid (R—CONH)⁻ 6307, pKₐ=−1 to −0.5. Amides are derived from carboxylic acids, i.e. acids containing a (—COOH), where the molecule's OH terminus is substituted with an NH₂ group resulting in the structure (R—CONH₂) which immediately deprotonates to form (R—CONH)⁻ 6307 in accordance with the equilibrium reaction

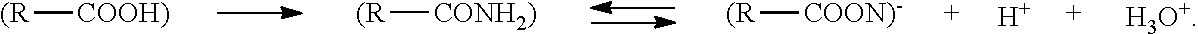

In solution the opposing side of the molecule labelled ‘R’ bonds to a radical such as CH₃ to form ethanamide (CH₃CONH₂) or the (CH₃CONH)⁻ anion. In an ionomer, exposed carbon ion bonds to the polymeric backbone rather than a radical R. Made in accordance with this invention, homo-ionomeric ion exchange membranes compatible with amide conjugate acids and immobile derivatives therefrom include the following polymers: polybenzimidazole (PBI); polyamide-imide (PAI), polyimides; poly(ether-ether ketone) (PEEK); poly(vinyl alcohol) (PVA) poly(ethylene oxide) (PEO); and others without limitation.

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Carboxylic Acid:

Similarly, carboxylic acid (R—COOH), pKa=+4 to +5, forms the immobile anion (R—COO)⁻ 6308 through deprotonation of its terminus hydrogen in accordance with the equilibrium reaction

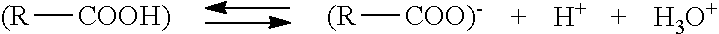

where the exposed hydrogen is ionized producing the monovalent anion (R—COO)⁻ 6308 referred to as carboxylate. Made in accordance with this invention, homo-ionomeric ion exchange membranes compatible with carboxylic acids and immobile derivatives therefrom include the following polymers: polybenzimidazole (PBI); poly(vinyl alcohol) (PVA) with carboxylic acid groups; poly(ether-ether ketone) (PEEK) with carboxylic acid groups; poly(ethylene oxide) (PEO) with carboxylic acid groups; polyimides with carboxylic acid groups; polysulfone (PSU) with carboxylic acid groups; and others without limitation.

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

### Phosphotungstic Acid:

Likewise, phosphotungstic acid (PWA), pKa=+3.1, is converted into the monovalent anionic ionomer phosphotungstate (PWA)⁻ 6309 through equilibrium reaction

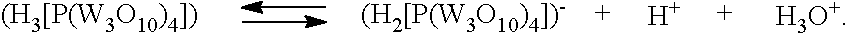

Made in accordance with this invention, homo-ionomeric ion exchange membranes compatible with phosphotungstic acid and immobile derivatives therefrom include the following polymers: polybenzimidazole (PBI); poly(vinyl alcohol) (PVA) with phosphotungstic acid groups; poly(ether-ether ketone) (PEEK) with phosphotungstic acid groups; poly(ethylene oxide) (PEO) with phosphotungstic acid groups; polyimides with phosphotungstic acid groups; polysulfone (PSU) with phosphotungstic acid groups; and others without limitation.

These polymers may by used in any combination with other inventive features of this application including endoskeletal support, micropores fabricated via sacrificial fillers, permanent fillers and dopants including ionic liquids, and membrane coatings including catalysts, scavengers, MOFs, and barriers against gaseous toxins such as carbon monoxide.

Other hydrocarbons and acids shown in FIG. 432B suitable for forming anionic ionomers include ethyl lactate (C₅H₁₀O₃) or chemically with the skeletal formula (CH₃CH(OH)CO₂CH₂CH₃)), pKₐ=14.2 converted into monovalent anionic ionomer (C₅H₉O₃)⁻ 6310; citric acid (C₆H₈O₇) with skeletal formula HOC(CH₂CO₂H)₂, pKₐ=+3.1, converted into monovalent anionic ionomer (C₆H₇O₇)⁻ 6311; glycolic acid (C₂H₄O₃) with the skeletal structure (HOCH₂CO₂H), pKₐ=+3.83, converted into monovalent anionic ionomer (C₂H₃O₃)⁻ 6312; diethylphosphate (DEP) or diethyl phosphoric acid, pKₐ 7=+1.5, converted into monovalent anionic ionomer (DEP)⁻ 6313; butyric acid (C₃H₇COOH), pKₐ=+4.82, converted into monovalent anionic ionomer (C₃H₇COO)⁻ 6314; pyruvic acid (C₃H₄O₃) or in skeletal form as (CH₃COCOOH), pKₐ=+2.49 converted into monovalent anionic ionomer (C₃H₃O₃)⁻; acetic acid (AA), pKₐ=+4.76 converted into monovalent anionic ionomer (AA)⁻ 6316; and trifluoromethane sulphonic acid or triflate (TF), pKₐ=−14 converted into monovalent anionic ionomer (TF)⁻ 6317.

These various ionomers are especially advantageous in IEMs of specific polymers. For example, because of its inert reactivity and chemical stability perfluorosulfonic acid (PFSA) polymer such as Nafion® is well suited for a range of ionomers including ethyl lactate, citric acid, glycolic acid, diethylphosphate, butyric acid, pyruvic acid, acetic acid, and triflate. For its superior thermal stability polybenzimidazole (PBI) enhances the performance of citric acid, glycolic acid, pyruvic acid, and acetic acid. Sulfonated polyether ether ketone (SPEEK) with is good chemical resistance and excellent proton conductivity is well matched to Citric acid, glycolic acid, pyruvic acid, acetic acid, and triflate.

With superior mechanical properties and resilience to chemical attack, polyvinylidene fluoride (PVDF) and polyetherimide (PEI) are both compatible with ethyl lactate, citric acid, glycolic acid, pyruvic acid, and acetic acid. For cost sensitive applications polypropylene (PP) and polyethylene (PE) can be used with ethyl lactate, citric acid, glycolic acid, butyric acid, pyruvic acid, and acetic acid. Other polymers compatible with citric acid, glycolic acid, pyruvic acid, acetic acid include polyvinyl alcohol (PVA), poly(ether-ether ketone) (PEEK), and polysulfone (PSU).

### Hetero-Ionomers IEMs.

Another class of ion exchange membrane made in accordance with this invention is a hetero-ionomer or dual-ionomer IEM. In such membranes, two different ionomers are included in the polymer matrix. By combining two different ionomers into the same film, the operating range of an ion exchange membrane can be expanded beyond that of single ionomer electrochemistry.

### Sulfuric-Sulfamic-Acid Co-Ionomer:

Representative examples of hetero-ionomer IEMs made in accordance with this invention as shown in FIG. 432C include co-sulfur dual-ionomer membrane 6360 combining sulfuric acid (H₂SO₄) 6300, pKₐ=−3, and sulfamic acid (H₃NSO₃) 6302, pKₐ=+1. In operation, the acids ionize into anions, releasing ionized hydrogen H⁺ 6358 in the solid electrolyte, which may combine with membrane generated water to form hydronium ions H₃O⁺ 6359. In operation, the concentration of protonated and deprotonated ionomer termini reach an equilibrium condition among ionomeric groups of neutral acids (H₂SO₄) and (H₃NSO₃); immobile ionomeric anions (HSO₄)⁻ and (H₂NSO₃)⁻; and mobile cations H⁺ 6358 and H₃O⁺ 6359; as given by the steady state expression

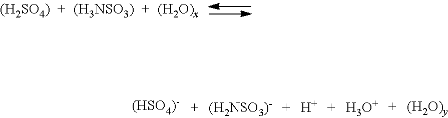

including the presence of water (H₂O)ₓ as a reaction solvent for the forward reaction ionizing neutral acids. Water identified as (H₂O)_{y} also plays a role dynamically managing proton and hydronium concentrations during charge transport. Aside from its solvent and transport abilities, water does not actively participate in deprotonation of the electrolyte's acids. Instead, membrane water is the product of the oxygen reduction reaction (ORR) converting transported protons reaching the anode catalyst layer (ACL) into water according to the reaction 4H⁺+4e⁻→O₂→2H₂O. Because however, water is neither a reactant nor product of the acid-ionomer equilibrium reaction, the ionomer's overall electrochemistry is more simply expressed as

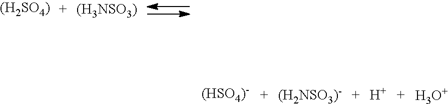

with the understanding described in a previous section of this application that the oxygen reduction reaction (ORR) occurring at the membrane-cathode catalyst-layer interface supplies the water necessary to hydrate the membrane and facilitate charge transport. Since the chemical activity of the two acids and their equilibrium constants differ, the combination of the two acids support ionomeric function over an extended range of pH and hydration levels. Other ions possibly added into the membrane such as functionalized permanent fillers and ionic liquids are not shown.

The sulfuric-sulfamic acid co-ionomer made in accordance with this invention is compatible with a variety of polymers including perfluorosulfonic acid—polytetrafluoroethylene copolymer (PFSA-PTFE); polybenzimidazole (PBI); sulfonated polyether ether ketone (SPEEK); polyvinylidene fluoride (PVDF); and the homopolymer polytetrafluoroethylene (PTFE).

### Sulfonic-Phosphonic-Acid Co-Ionomer:

As represented, a heterogenous mixed-acid dual-ionomer membrane 6361 made in accordance with this invention combines sulfonic acid (HSO₃) 6301, pKₐ=+0.754 and phosphonic acid (H₃PO₃), pKₐ=+1.3, by the equilibrium reaction

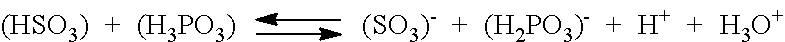

to form two immobile anionic ionomers (SO₃)⁻ 6301 and (H₂PO₃)⁻ 6305. Although renowned for its high proton conductivity, sulfonic acid can suffer from dehydration at higher temperatures. By combining sulfonic acid with phosphonic acid, the resulting hetero-ionomer membrane exhibits better thermal stability and mechanical properties than its homo-ionomer constituents. The combination also provides more uniform conductivity over a range of humidity levels and temperatures.

A sulfonic-phosphonic-acid co-ionomer made in accordance with this invention is compatible with a variety of polymers including perfluorosulfonic acid—polytetrafluoroethylene copolymer (PFSA-PTFE); poly(arylene ether sulfone) (PAES); polybenzimidazole (PBI); polyphosphazenes (Pz); and polyvinylidene fluoride (PVDF).

### Sulfonic-Acid Phenol-Hydroxide Co-ionomer:

Another hetero-ionomer membrane 6362 made in accordance with this invention combines sulfonic acid (HSO₃), pKₐ=+0.754 and phenol hydroxide (Ph-OH), pKₐ=+10 together by the equilibrium reaction

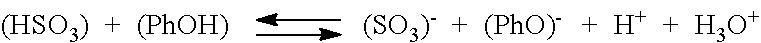

forming two immobile anionic ionomers (SO₃)⁻ 6301 and phenol hydroxide (PhO)⁻ 6304 along with mobile charge carriers of hydrogen ions H⁺ 6358 and hydronium ions H₃O⁺ 6359. The unique combination of the two acids provides a synergistic effect in conductivity by combining the strong acidic properties of sulfonic acid with an acid less sensitive to pH and ambient conditions.

And since phenol hydroxide groups offer improved thermal stability, the hetero-ionomeric membrane is well suited for high-temperature applications where maintaining membrane integrity is crucial. Moreover combining sulfonic acid and phenyl hydroxide groups can help manage hydration within the membrane. This is especially important for maintaining proton conductivity and preventing dehydration, especially under low-humidity conditions.

Another feature of the inventive sulfonic acid—phenol hydroxide co-ionomer IEM is enhanced chemical stability. Specifically, the hetero-ionomer is inherently resistant to oxidative and hydrolytic degradation, extending the membrane's lifespan and improving its performance and tolerance to harsh environments, e.g. when exposed to environmental toxins and poisons. A unique benefit of this hetero-ionomer membrane is its ability to reduce fuel crossover of either hydrogen or methanol.

A sulfonic-acid-phenol-hydroxide co-ionomer made in accordance with this invention is compatible with a variety of polymers including polysulfone (PSU); polyether ether ketone (PEEK); polybenzimidazole (PBI); poly(arylene ether sulfone) (PAES); and polyvinylidene fluoride (PVDF).

### Sulfosuccinic-Sulfonic-Acid Co-Ionomer:

Another hetero-ionomer membrane 6363 made in accordance with this invention combines sulfosuccinic acid (SSA, C₄H₆O₇S), pKₐ=+1.5, and sulfonic acid (HSO₃), pKₐ=+0.754 together by the equilibrium reaction

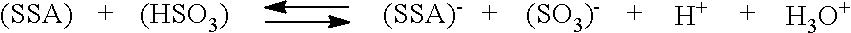

forming two immobile anionic ionomers (SSA)⁻ 6303, chemically as (C₄H₅O₇S)⁻ and sulfonic acid (HSO₃)⁻ 6301 along with mobile charge carriers of hydrogen ions (H)⁺ 6358 and hydronium ions (H₃O)⁺ 6359. The unique combination of the two acids provides two chemical variants of sulfonated ionomers together offering superior conductivity over a wide range of hydration levels with superior water retention in low humidity conditions. Sulfosuccinic acid offers the characteristic of improved thermal stability of the membrane, making it suitable for high-temperature applications. Together combination of the two sulfonated co-ionomers offers good resistance to chemical degradation, extending a membrane's lifespan and enhanced mechanical strength exhibiting flexible mechanical properties ensuring durability under operational stresses.

The sulfosuccinic-sulfonic-acid co-ionomer made in accordance with this invention is compatible with a variety of polymers including poly(arylene ether sulfone) (PAES); polybenzimidazole (PBI); polyvinylidene fluoride (PVDF); polysulfone (PSU); polyether ether ketone (PEEK); and polystyrene sulfonate (PSS).

### Pyruvic-Butyric-Acid Co-Ionomer:

Other representative examples of hetero-ionomer IEMs made in accordance with this invention as shown in FIG. 432D one of which comprises a hetero-ionomer membrane 6364 made in accordance with this invention combining pyruvic acid (C₂H₄O₃), pKₐ=+2.49 with butyric acid (C₃H₇COOH), pKₐ=+4.82, together by the equilibrium reaction

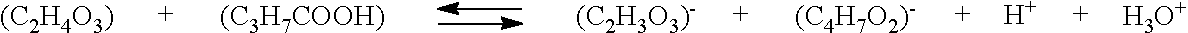

forming two immobile anionic ionomers, the pyruvate anion (C₂H₃O₃)⁻ 6315, and butyrate anion (C₄H₇O₂)⁻ 6314 along with mobile charge carriers of hydrogen ions H⁺ 6358 and hydronium ions H₃O 6359. The pyruvate anion (C₂H₃O₃)⁻ is a 2-oxo monocarboxylic acid anion that is the conjugate base of pyruvic acid. Butyrate is the conjugate base of butyric acid, formed by deprotonation of the carboxy group in butyric acid.

Benefits of combining pyruvate and butyrate anions into an hetero-ionomeric film include higher conductivity and enhanced flexibility. Pyruvic acid also improves the thermal stability of the membrane. Both acids are biodegradable, making the membrane more environmentally friendly. As a disadvantage, bio-membranes can be more susceptible to chemical degradation, especially in harsh operating conditions.

The pyruvic-butyric-acid co-ionomer made in accordance with this invention is compatible with a variety of polymers including polyethylene (PE); polypropylene (PP); poly(ethylene-co-methacrylic acid) (PEMAA); poly(vinyl alcohol) (PVA); and poly(acrylic acid) (PAA).

### DEP-Triflate Co-Ionomer:

The hetero-ionomer membrane 6365 made in accordance with this invention combines diethylphosphate (DEP, C₄H₁₀O₄P), pKₐ=+1.5, and dilute trifluoromethane-sulphonic acid (triflate, —OTf, CF₃SO₃H), pKₐ=+14, together by the equilibrium reaction

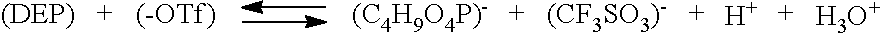

forming two immobile anionic ionomers, the diethylphosphate anion (C₄H₉O₄P) 6313, and triflate anion (CF₃SO₃)⁻ 6317 along with mobile charge carriers of hydrogen ions (H)+6358 and hydronium ions (H₃O)⁺ 6359. The triflate anion (CF₃SO₃)⁻ 6317 is an extremely stable polyatomic ion derived from the superacid triflic acid (CF₃SO₃H). Triflate may be synthesized in any number of variants comprising the formula R—OSO₂CF₃ and the general structure R—O—S(═O)₂—CF₃ often simplified to the notation —OTf. With a pKₐ=−14, triflate is one of the strongest acids known and therefore must be used in extremely weak concentrations to avoid damaging the membrane's polymeric structure.

By contrast DEP is a dialkyl phosphate having ethyl as the alkyl group and a conjugate acid of diethylphosphate, i.e. DEP⁻. With a pKₐ=+1.95, although still considered a strong acid, DEP is a significantly weaker acid than triflate. The unique combination of dilute triflate with DEP confers numerous advantages to a membrane including excellent proton conductivity enhancing PEM efficiency, superior resistance to chemical attack thereby extending its operational life, and uniquely low swelling maintaining structural integrity over a wide range of environmental and operational conditions. Moreover, diethylphosphate improves the membrane's thermal stability.

The DEP-triflate co-ionomer made in accordance with this invention is compatible with a variety of polymers including polyethylene oxide (PEO); poly(methyl methacrylate) (PMMA); polyvinylidene fluoride (PVDF); poly(ethylene-co-vinyl acetate) (EVA); and poly(acrylonitrile) (PAN).

### Citric-Acetic-Acid Co-Ionomer:

The hetero-ionomer membrane 6366 made in accordance with this invention combines citric acid (CA, C₆H₈O₇) 6311, pKₐ=+3.1, with acetic acid (AA, CH₃COOH), pKₐ=+4.76, together by the equilibrium reaction

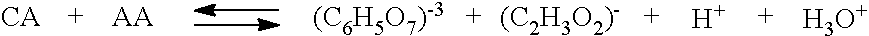

forming two immobile anionic ionomers, the citrate anion (C₆H₅O₇)⁻³ 6311, and acetate anion (C₂H₃O₂)⁻ 6316 along with mobile charge carriers of hydrogen ions H⁺ 6358 and hydronium ions H₃O 6359. With a skeletal structure HOC(CO₂H)(CH₂CO₂H)₂ citric acid is a weak organic acid occurring naturally in fruits and vegetables which may be concentrated for industrial purposes. Citric acid is a weak tribasic acid with pKa values of 3.128, 4.761, and 6.396. The citrate anion (C₆H₅O₇)⁻³ is trivalent comprising tricarboxylic acid trianion, obtained by deprotonation of the three carboxy groups of citric acid. Acetic acid 6311 is a moderately weak hydrocarbon based acid with pKₐ=4.76 having a structure CH₃COOH where the only the last oxygen-attached hydrogen is an acidic proton. Acetic acid, the main component of vinegar from which its name was derived, may also be written formulaically as CH₃CO₂H, C₂H₄O₂, HC₂H₃O₂, or by the pseudo-element symbol AcOH.

The benefit of combining citric and acetic acids together to form an a ionomeric membrane is primarily one of biocompatibility and safety. Although weak acids result in lower conductivities than using strong acids, they are safer for the environment, users, and manufacturers. That said, since both acids are efficient proton donors, their combination can exhibit enhanced conductivities over their homo-ionomer constituents. Because citric acid has multiple carboxyl groups, its use can improve the hydration properties of the membrane in in maintaining high proton conductivity even at lower humidity levels. Furthermore, since citric acid has a higher boiling point compared to acetic acid, it contributes to the thermal stability of the membrane allowing the hetero-ionomeric membrane to operate efficiently at a broader range of temperatures.

The combination of citric and acetic acids offers good chemical stability via a balanced chemical environment, enhancing the chemical stability of the membrane and resisting degradation over time, thereby extending the operational life of the membrane. In terms of mechanical stability, citric acid readily cross-links with other polymer chains, potentially enhancing the mechanical strength and durability of the PEM membrane rendering it more resilient to mechanical stress and deformation. The use of this inventive citric-acetic co-ionomer also confers beneficial advantages in limiting fuel crossover in direct methanol fuel cells (DMFCs) through reduced methanol permeability, thereby improving the overall efficiency of the fuel cell. And since both citric acid and acetic acid are relatively inexpensive and readily available, PEM membranes fabricated with them offer a cost-effective option compared to using extremely caustic chemicals.

Aside from biocompatibility in use, fuel cells based on a citric-acetic acid membrane offer benefits in biocompatible recycling. Both citric acid and acetic acid are biodegradable and environmentally friendly. Using them in PEM membranes can contribute to the development of more sustainable and eco-friendly fuel cell technologies especially when combined with natural polymers such as chitosan and cellulose acetate.

The citric-acid acetic-acid co-ionomer made in accordance with this invention is also compatible with a variety of polymers including poly(vinyl alcohol) (PVA); poly(ethylene glycol) (PEG); poly(acrylic acid) (PAA); poly(ethylene-co-methacrylic acid) (PEMAA); and poly(vinyl acetate) (PVAc).

The benefit of blending ionomers made in accordance with the invention is to combine dissimilar features to enhance structural or electrical properties of the membrane. As described in the prior examples, this benefit may involve combining an ionomer with enhanced durability or strength with another providing enhanced conductivity. Another example is to combine an ionomer which works well under low hydration conditions but is inefficient in high humidity with another ionomer that functions best in humid conditions without suffering water logging. Another advantageous combination blends an ionomer with good conductivity at low temperatures with another that works best at elevated temperatures.

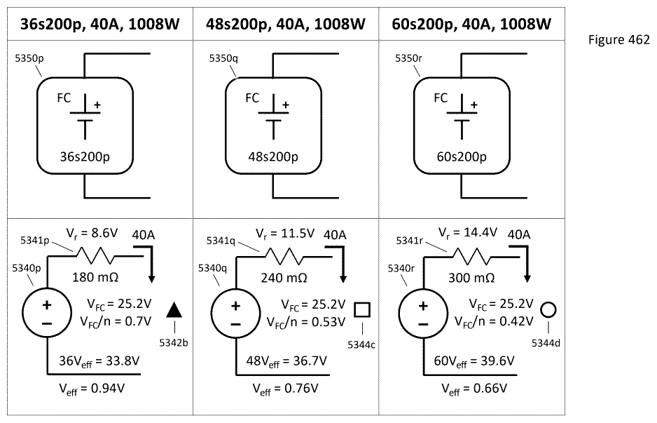

The key design principle in engineering a hetero-ionomeric membrane in accordance with this invention is that at least one characteristic parameter between the two ionomers exhibits different optimum operating conditions. The benefit of a hetero-ionomer membrane is to expand the operational range of the film, synergistically enhance its performance, or both. This principle is illustrated graphically in FIG. 462E in a graph comparing ‘IEM Performance’ such as conductance, flexibility, durability, power cycling life, use life, versus shown on the ordinate axis versus the “Operating Condition’ such as pH, temperature, humidity, current density shown on the abscissa. As illustrated the parametric performance of two ionomers, ionomer-A 6360 and ionomer-B 6361 not only exhibit different characteristics and magnitudes, but the operating condition range where the peak performance for each ionomer occur are offset.

For example, if the x-axis is operating temperature and the y-axis represents conductivity, ionomer-B 6361 exhibits greater performance and at higher temperatures than ionomer-B 6361. At lower temperatures however, ionomer A 6360 outperforms ionomer-B in the lower temperature range. Although the performance criteria shown is exemplary of a fuel cell, the same co-ionomer membrane can for example be used for air and water filtration, chemical processing and catalysis, kidney dialysis, and deionization except the performance parameters are different. For example, filter performance may be measured by egress selectivity, catalytic rates, solid removal, fluid turbidity, particulate density, fluid pH, etc. while operating conditions may include temperature, ingress viscosity, pH, turbidity, flow rate, etc.

### Permanent Fillers.

During membrane fabrication, permanent fillers may be added to the mold compound of any ionomeric polymer to enhance performance. Permanent fillers made in accordance with invention include bismuth compounds, graphene oxides; carbon nanotubes; silicates and zeolites; zirconium, tungsten and transition metals; metal-organic-frameworks (MOFs); nanostructures including PMMA, POSS, nanofibers and nanoparticles; polyoctahedral and double-decker silsesquioxanes (POSS, DDSQ); and functionalized triazines frameworks.

### Bismuth Compounds:

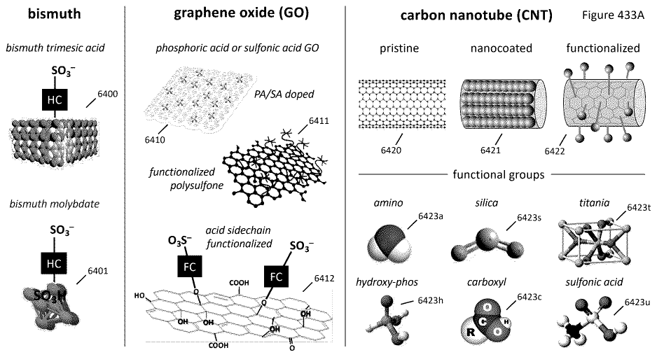

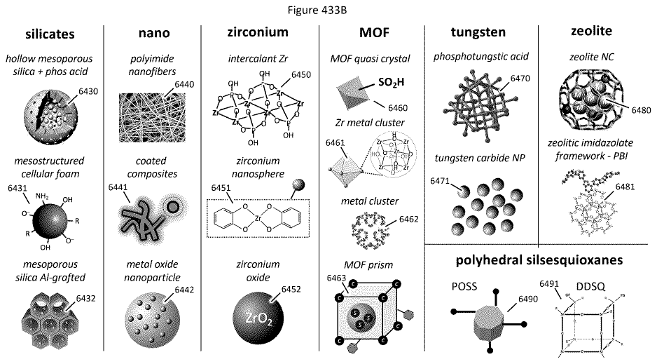

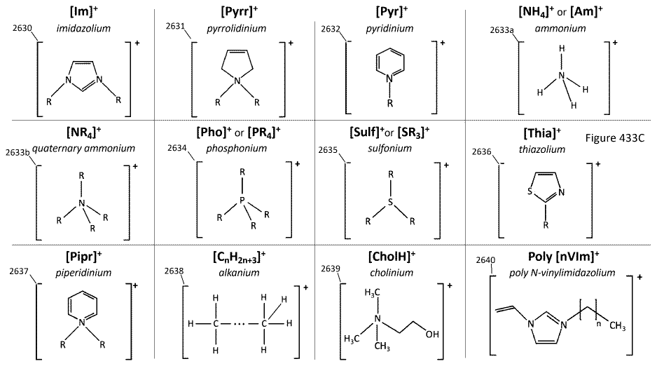

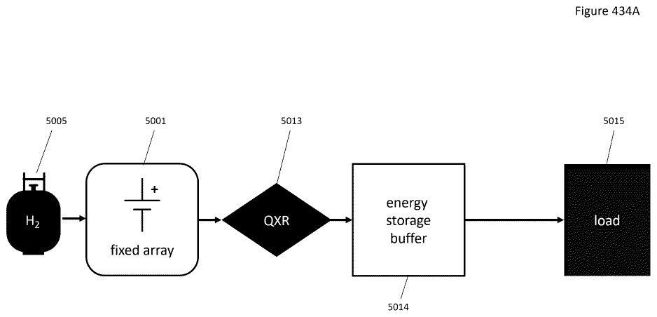

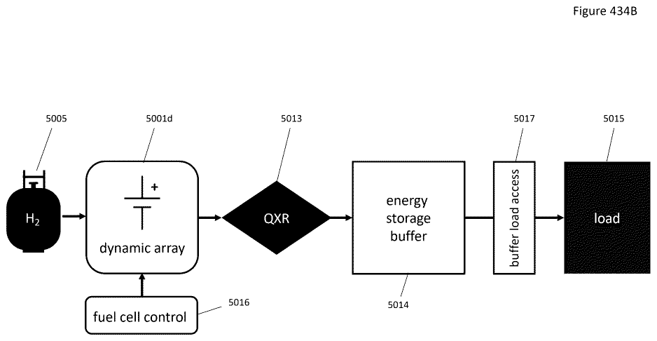

One category of permanent filler depicted in FIG. 433A is compounds of bismuth. Bismuth, the most metallic like chemical element of the nitrogen group, is a post transition metal in group 15 (classic periodic group V) able to stably bond with carbon, oxygen and hydrocarbon compounds and polymeric matrices. Although a variety of electrically active bismuth compounds exist, two variants demonstrated to contribute to ionic conduction include bismuth trimesic acid (Bi-BTC) 6400 and bismuth molybdate (Bi₂O₃·nMoO₃) 6401 where n=3 corresponds to α=(—Bi₂Mo₃O₁₂); n=2 corresponds to the compound β=(—Bi₂Mo₂O₉), and n=1 corresponds to the compound γ=(—Bi₂MoO₆). These bismuth compounds may attach to ionomeric acids groups such as sulfonic acids, phosphonic acids, phosphoric acids, or other acids via a hydrocarbon (HC) sidechain or ligand. For example, bismuth trimesic acid (Bi-BTC) 6400 can bond to sulfonic acid to form the ionomeric permanent filler (Bi-BTC-HC—(SO₃)⁻). In another exemplary bismuth molecule, bismuth molybdate (Bi₂O₃·nMoO₃) 6401 is bound to sulfonic acid via a hydrocarbon (HC) sidechain or ligand acid to form the ionomeric permanent filler ((Bi₂O₃·nMoO₃)—HC—(SO₃)⁻).

Made in accordance with this invention, bismuth compounds introduced into the polymer matrix act as reinforcing agents, improving the mechanical strength and durability of the membrane, a feature particularly important for maintaining membrane integrity under operational stress and high-temperature conditions. The incorporation of bismuth permanent fillers also enhances the flexibility and toughness of the membrane, reducing the likelihood of cracking or tearing. Bismuth compounds incorporated as nanoparticles also create a more uniform and finely structured membrane matrix, enhancing the dispersion of the fillers and improving the overall performance of the membrane.

In another embodiment, the incorporation of bismuth compounds into the matrix also invoke changes in the morphology of the membrane, such as pore size and distribution, beneficially influencing the membrane's transport properties and improving its overall efficiency. In one class of embodiments made in accordance with this invention, the membrane is formed with permanent fillers added prior to molding or casting the film into its final morphology and stoichiometry.

Made in accordance with this invention, bismuth compounds introduced into the polymer matrix act as reinforcing agents, improving the mechanical strength and durability of the membrane, a feature particularly important for maintaining membrane integrity under operational stress and high-temperature conditions. In one embodiment, the incorporation of bismuth permanent fillers also enhances the flexibility and toughness of the membrane, reducing the likelihood of cracking or tearing. Bismuth compounds incorporated as nanoparticles also create a more uniform and finely structured membrane matrix, enhancing the dispersion of the fillers and improving the overall performance of the membrane.

In another embodiment, the incorporation of bismuth compounds into the matrix also invoke changes in the morphology of the membrane, such as pore size and distribution, beneficially influencing the membrane's transport properties and improving its overall efficiency. Bismuth enhances chemical stability, rendering making the film more resistant to degradation by chemical species such as free radicals, acids, or bases. Bismuth compounds can also be included in a nanoparticle coating or embedded into the catalyst layer. For example, made in accordance with this invention the addition of these bismuth compounds into the cathode catalyst layer (CCL) accelerate the oxygen reduction reaction (ORR), the rate limiting reaction in a PEM fuel cell.

Bismuth enhances chemical stability, rendering making the film more resistant to degradation by chemical species such as free radicals, acids, or bases. Bismuth compounds can also be included in a nanoparticle coating or embedded into the catalyst layer. For example, made in accordance with this invention the addition of these bismuth compounds into the cathode catalyst layer (CCL) accelerate the oxygen reduction reaction (ORR), the rate limiting reaction of a PEM fuel cell. Applications of bismuth compounds in ionomeric membranes include enhancing proton exchange membranes (PEMs) in fuel cells to improve their efficiency, durability, and performance; enhancing the efficiency of water splitting by improving ion conductivity and catalytic activity in water electrolyzers; improve ion transport and overall battery performance in batteries, and in enhance sensitivity and selectivity for chemical sensors.

### Graphene Oxides:

In another set of embodiments made in accordance with invention, graphene oxides (GO) are introduced into the membrane's polymeric matrix. The graphene oxides shown in FIG. 433A may be functionalized by acids 6410 such as sulphonic acid (GO-SA) or phosphonic acids (GO-PA), by fluorocarbon sidechains (GO-FC-SA) 6412, or integrated with polysulfone (GO-PSf) 6411 can significantly enhance the performance of ion exchange membranes (IEMs) in fuel cells and other applications.

Specifically acid groups 6410 such as sulphonic acid (GO-SO₃H) are highly proton-conductive. When GOs are functionalized with sulphonic acid, the proton conductivity of the membrane increases, which is crucial for the efficient operation of proton exchange membrane fuel cells (PEMFCs). Similarly, other acid groups 6410 comprising phosphonic acid (GO-PO₃H₂) also contribute to proton conductivity, and their incorporation can enhance the membrane's ability to conduct protons, improving overall fuel cell performance.

Acidic functional groups facilitate proton hopping mechanisms, where protons are transferred from one functional group to another. This can significantly boost the overall proton conductivity of the membrane. Furthermore the presence of functional groups form continuous pathways for proton transport reducing membrane resistance, leading to higher efficiency and reduced self heating.

Acid functionalization of graphene oxides made in accordance with this invention also enhances the chemical stability of a ion exchange membrane. Specifically, the presence of strong acidic groups like sulphonic and phosphonic acids resist oxidative degradation, thereby maintaining membrane integrity over prolonged use in aggressive fuel cell environments. In particular, functionalizing GOs can improve the chemical stability of the membrane, making it more resistant to degradation from reactive species such as radicals and extending the operational lifetime of the membrane.

Furthermore, functionalizing GOs with hydrophilic groups such as sulphonic, phosphonic, or phosphoric acids enhances the water retention capability of the membrane. Adequate water content is essential for maintaining high proton conductivity and preventing membrane dehydration, which can lead to reduced performance and durability. Functional groups such as carboxyl, hydroxyl, and sulphonic acids are hydrophilic, meaning they can attract and retain water molecules. This is beneficial for maintaining the hydration levels necessary for efficient proton conduction.

Membrane swelling in the presence of water made in accordance with this invention is controlled by the type and density of functional groups. Properly balanced swelling can enhance proton conductivity without compromising mechanical strength. Moreover, as a unique embodiment enhanced water retention is counterbalanced by the mechanical rigidity and structural support of the inert skeletal structure disclosed herein, whereby the tendency for membrane swelling, water logging, and film deformation are suppressed.

Acidic functional groups bonded to graphene oxide increase the ion exchange capacity of the IEM film. This is particularly beneficial in applications where selective ion transport is crucial, such as in electrodialysis or redox flow batteries. Functionalized GOs also reduce the fuel crossover. e.g. hydrogen or methanol through the membrane, enhancing fuel cell efficiency, preventing performance losses, and suppressing ionomer and catalyst degradation.

Another aspect of membranes integrating graphene oxides made in accordance with this invention is tailored morphology. Specifically, the integration of functionalized GOs forms well-defined nanostructures within the membrane facilitating enhanced proton transport while maintaining mechanical integrity. Polysulfone is known for its excellent mechanical properties and thermal stability. Integrating GOs with polysulfone in accordance with this invention produces mechanically robust membranes able to withstand the harsh operational conditions of fuel cells.

The introduction of functionalized graphene oxides can also promote the formation of layered structures, further enhancing proton conductivity through contiguous porous channels while maintaining mechanical strength. Functionalized GOs also function as molecular reinforcing agents within the polymer matrix, enhancing the mechanical strength and durability of the membrane. This is particularly important for maintaining structural integrity under operational stress.

Functional groups like sulphonic and phosphonic acids attached to a graphene oxide substrate improve the thermal stability of an ionomeric membrane, especially beneficial in applications where an IEM is subjected to high temperatures, thereby ensuring consistent performance and longevity. Enhanced thermal stability also means that the membrane is less likely to decompose at high temperatures, ensuring long-term durability and reliability.

Lastly, the introduction of functionalized graphene oxides into the membrane in accordance with this invention can be tailored to selectively allow the transport of protons while blocking other ions. This selectivity is crucial for maintaining the efficiency of the fuel cell by preventing the crossover of unwanted ions. By enhancing ion selectivity, functional groups can also suppress fuel crossover and counter adverse effects therefrom.

### Carbon Nanotubes:

As an embodiment of this invention carbon nanotubes (CNTs), whether a pristine CNT 6420, a nanocoated CNT 6421, or a functionalized CNT 6422, offer unique properties that can significantly alter and improve the performance of ion exchange membranes (IEMs) in fuel cells and other applications. By introducing permanent fillers containing CNTs into an ion exchange membrane in accordance with this invention, numerous benefits include enhanced proton efficiency; enhanced thermal stability; reduced fuel crossover; improved water management; and enhanced electrocatalytic activity.

Without functionalization, pristine CNTs 6420 create pathways in a polymeric matrix that improve proton transport due to high surface area and excellent thermal and electrical conductivity. Depending on the polymer, pristine CNTs interstitial to a membrane may enhance mechanical properties by acting as reinforcing agents within the membrane matrix similar to the action of carbon fibers, providing structural support and increasing tensile strength. Because of their inability to bond directly onto a polymer's lattice, enhancement in a film's tensile strength is minimal. Pristine CNTs have inherently high thermal stability, which helps maintain the integrity of the membrane under thermal stress. Pristine CNTs can also contribute to reducing methanol crossover by enhancing the barrier properties of the membrane and in maintaining an optimal water balance within the membrane, crucial for consistent performance in fuel cells. CNTs also enhance electrocatalytic activity, aiding in the overall reaction kinetics within the fuel cell.

Although pristine CNTs 6420 can improve electrical, mechanical, chemical, and thermal properties of an ionomeric polymer, in their native form, the poor wettability, weak interfacial boding, and hydrophobicity of carbon nanotubes are unable to strengthen a material matrix. In accordance with this invention, one means to enhance the surface reactivity of CNT is by coating its surface with nanocoatings of metals, metal alloys, and metal polymers. The resulting nanocoated CNTs 6421 are able to enhance the electrical, thermal, catalytic, and ionomeric properties of pristine nanotubes by facile coating processes. The nanocoating process may involve electroplating, electroless plating, and ultrasonic spray atomization processes, primarily of silver (Ag), copper (Cu), nickel (Ni), cobalt (Co), gold (Au), and various metallic alloys such as nickel-phosphorus (Ni—P), nickel-cobalt (Ni—Co), and nickel-cobalt-phosphorus (Ni—Co—P). By improving the surface reactivity nanocoated CNTs are better suited as a permanent filler in membranes featuring magnetic and ferromagnetic, electrically and thermally conductive properties, and catalytic capabilities.

The high catalytic activity and thermal conductance of metal nanocoated CNTs is similar to fillers of metal-organic-frameworks (MOFs). In one embodiment the addition of nanocoated CNTs into a membrane's ionomeric polymeric matrix equilibrates temperature gradients within the polymer. By introducing scavenger metal coated CNTs such as nickel and cobalt into the membrane, its membrane nanocoating, or into the catalyst layer, toxic carbon monoxide can be captured before doing damage to ionomers and catalysts. Made in accordance with this invention, the inclusion of a low density of platinum, palladium, or titanium coated CNTs can also suppress fuel cross over converting stray hydrogen into protons within the film's atomic matrix enhancing fuel cell conversion efficiency and further suppressing the formation of damaging peroxides (H₂O₂).

A variant of a nanocoated CNT also shown in FIG. 433A is a functionalized CNT 6422 where the surface of the carbon nanotube is modified to attach to various organic functional groups or inorganic compounds, salts or crystals. In various embodiments functional groups such as sulfonic acid, carboxyl, or amine groups can be attached to CNTs to improve their proton conductivity. These functional groups facilitate the transport of protons through the membrane, enhancing the overall efficiency of the fuel cell.

Structurally, the CNT bound functional groups interact with the polymeric matrix of the membrane, leading to better dispersion, stronger interfacial bonding, and improved mechanical properties of the membrane, thereby making it more durable and resistant to degradation. The introduction of functional groups also improve the thermal stability of the CNTs, in turn enhancing the thermal stability of the ion exchange membrane, a characteristic crucial for applications operating at elevated temperatures. Furthermore, in direct methanol fuel cells (DMFCs), functionalized CNTs reduce methanol crossover creating a more tortuous path for methanol molecules, thereby improving fuel efficiency.

In another embodiment, the hydrophilicity of functionalized carbon nanotubes attract water molecules, improving the hydration of the membrane and thus enhancing its ionic conductivity. Certain functional groups can impart electrocatalytic properties to CNTs, which can be beneficial for reactions occurring at the membrane interface. CNTs can also be used in ion exchange membranes for water purification systems, enhancing ion selectivity and increasing the efficiency of contaminant removal.

As various embodiments of this invention, both functionalized and pristine carbon nanotubes offer unique benefits that can significantly improve the performance of ion exchange membranes in fuel cells and other applications. Functionalized CNTs provide additional chemical functionality that can be tailored for specific needs, while both pristine and functionalize CNTs offer inherent properties that enhance conductivity, mechanical strength, and stability. The benefit of CNT functionalization depends on the functional group itself. These groups include amino, silica, titania, hydroxy-phosphorus, and carboxyl group, along with various exemplary acids including sulfonic acid, phosphonic acid, and phosphoric acids. The role of functionalized of CNTs in an ion exchange membrane depends not only on the functional group but on the application of the membrane.

For example CNTs functionalized by amino groups (CNT-NH₂) 6423a exhibit a variety of changes involving increased hydrophilicity, enhanced chemical reactivity, and improved membrane selectivity, characteristics important in ion exchange membrane based filters such as water desalinization, deionization, aqueous turbidity and solid particulate separation, protein removal, and other cases. Amine-functionalized CNTs can also be used in photocatalytic applications for environmental remediation, such as the degradation of organic pollutants under light irradiation.

An amino group is an organic compound containing nitrogen and hydrogen called amine. Since nitrogen, like oxygen is more electronegative than either carbon and hydrogen, amino groups exhibit some polar character similar to water. The presence of amino groups on the surface of a carbon nanotube modifies the normally hydrophobic character of carbon nanotubes into a hydrophilic CNT, improving their dispersion in aqueous solutions and enhancing its aqueous chemical reactivity. The introduction of amine groups can enhance the gas adsorption and separation capabilities of CNTs, which is useful in applications like hydrogen storage and carbon dioxide capture.

In another embodiment of this invention involving ion exchange reactions (not shown), the combination of both amino and ionomeric functionalized coatings on a carbon nanotube assist in luring water into the vicinity of the ionomer thereby enhancing charge transport and proton exchange. Amino-functionalized CNTs also can form strong interactions with other molecules or materials, enhancing the mechanical properties and selectivity of the membrane, including improving the attachment of CNTs to the polymer's backbone.

Silica functionalized CNTs 6423s exhibit significantly enhanced mechanical strength and durability, improved thermal stability and better resistance to chemical degradation, together rendering membranes containing silica functionalized CNT more robust with longer cycle life. Titania functionalized CNTs 6423t impart antibacterial properties to a membrane, thereby preventing biofouling. Titania can enhance the UV resistance of CNTs, making the membranes more suitable for UV microbe sterilization applications. Titania-functionalized CNTs also exhibit photocatalytic properties, also beneficial for applications like water purification and pollutant degradation. In ion exchange membranes, the antimicrobial and antifouling behavior of titania functionalized CNTs confers enhanced filter performance especially in applications involving effluent filtration or in electrodialysis

Made in accordance with this invention, carbon nanotubes can also be decorated with hydroxy-carbon groups 6423h (CNT-P(OH)₂). These functional groups impart flame-retardant properties to CNTs, enhancing the fire safety of membranes, and improve compatibility of CNTs with other materials, such as polymers, enhancing the overall performance of composite membrane containing CNTs as permanent filers. Unlike the inert carbon surface of a pristine CNT, hydroxy-phosphorus groups can participate in numerous chemical and electrochemical reactions useful in tailoring membrane properties.

In another class of embodiments the CNTs are functionalized only by hydroxide (CNT-OH) groups without the added phosphorus. By themselves, hydroxyl groups enhance the biocompatibility of CNTs, making them more suitable for biomedical applications and also improve the mechanical properties of CNT composites by promoting bonding between the CNTs and the polymer matrix. Hydroxyl-functionalized CNTs also exhibit improved thermal stability, making them suitable for applications that require high-temperature resistance. By acting as catalytic sites, hydroxyl groups enhance the catalytic activity of CNTs in various chemical reactions. Hydroxyl-functionalized CNTs can be used in environmental applications such as pollutant adsorption and water purification due to their enhanced reactivity and adsorption capabilities. Both amine (CNT-NH₂) and hydroxyl (CNT-OH) functional groups play valuable roles in enhancing the properties and functionalities of carbon nanotubes (CNTs) for a wide range of applications.

In another embodiment carboxyl functionalized carbon nanotubes (CNT-C(O)OH) 6423c are used as permanent fillers in ion exchange membranes. Like amino groups, carboxyl groups significantly increase the hydrophilicity of CNTs, improving water permeability in filtration applications and preventing drying out of IEMs in electrochemical applications such as fuel cells. Carboxyl groups also serve as reactive sites for numerous chemical modifications, allowing for the attachment of various functional molecules to tailor the membrane properties. Carboxyl groups can also enhance the dispersibility of CNTs in aqueous and organic solvents, leading to more uniform membrane structures. In one embodiment carbon nanotubes functionalized by a combination of carboxyl groups together with one or more ionomeric acids such as sulfonic acid, phosphonic acid, or others are introduced as permanent fillers during synthesis of an ion exchange membrane. In this scenario the carboxyl group assists in the uniform dispersion of the CNTs throughout the membrane while the acid groups enhance the films conductivity and carrier mobility. Carboxyl-functionalized CNTs can exhibit ion exchange properties, beneficial in water softening and desalination processes and in enhancing IEM efficiency in fuel cells.

In one class of embodiments, the introduction of acid functionalized carbon nanotubes as permanent fillers in an ion exchange membrane offers a number of advantages to film properties including improved conduction and charge transport in a proton exchange membrane (PEM), enhanced hydrophilicity, accelerated catalysis, flame retardancy, corrosion resistance, biocompatibility, improved metal ion coordination, better ion exchange, and improved electrochemical performance.

Examples of acid functionalized CNTs include sulfonic acid (CNT-SO₃H) 6423s, phosphonic acid (CNT—PO₃H₂), and phosphoric acid (CNT—PO₄H₂). The presence of sulfur and phosphor acid groups enhances the proton conductivity of CNTs, making them suitable for use in proton exchange membranes for fuel cells. These acid groups significantly increase the hydrophilicity of CNTs, making them more dispersible in aqueous solutions, beneficial for various applications requiring homogeneous dispersion in water and in polar solvents during fabrication. Acid-functionalized CNTs can act as strong acid catalysts in various chemical reactions, including esterification, alkylation, polymerization, and hydrolysis. They are particularly useful in heterogeneous catalysis.

In other embodiments, acid groups are added as permanent fillers in membranes to better facilitate ion exchange processes useful in water purification, deionization, and softening applications. Acid groups also can enhance the biocompatibility of CNTs, making them more suitable for biomedical applications, and can better coordinate with metal ions, useful in applications like water purification, heavy metal ion removal, and catalysis. Made in accordance with this invention, the incorporation of acid groups can improve the corrosion resistance of CNT-based materials, making them suitable for extended membrane life or used as protective coatings.

The incorporation of acid functionalized CNTs also improve the flame retardant properties membranes and coatings, making them useful to improve membrane safety and in composite materials for fire-resistant applications. Finally acid functionalized CNT materials and membranes enhance electrochemical properties, making them beneficial for use in energy storage devices such as supercapacitors and lithium-ion batteries.

FIG. 433B illustrates a variety of other permanent fillers made in accordance with this invention including silicates and zeolites; metal organic frameworks (MOFs); zirconium, tungsten, and transition metals; and nanostructures, The incorporation of these and related permanent fillers into a polymeric matrix can significantly enhance the electrical, mechanical, thermal, chemical, and structural properties of IEMs. These improvements can lead to better performance, durability, and efficiency of membranes in various electrochemical applications including fuel cells, super capacitors, batteries, and filters for gas and liquids. Collectively these benefits can extend the use life of an ion exchange membrane, and thereby reduce the need for frequent replacement and the downtime. associated with swapping out used membranes for new. It also can reduce solid waste and associated recycling costs. Although each item can be described separately, for the sake of brevity come of the fillers have been categorized by their functional similarities, namely silicates and zeolites, and zirconium and tungsten. MOFs and nanostructures are already broad categories and are not combined with other permanent fillers.

### Silicates and Zeolites:

A silicate is a large family of molecules having the general tetrahedral structure (SiO₄)⁴⁻ comprising a central silicon atom surrounded by four oxygen atoms. Silicates are derived from a family of charge-neutral molecules called silica, also known as silicon dioxide (SiO₂), comprising a variety of covalently bound molecules such as quartz, cristobalite, and tridymite, which can interconvert at certain temperatures.

Given the high enthalpy of the silicon-oxygen bond (Si—O), silicates are resistant to attack by most acids unless if the presence of HF or NaOH. In the case of HF etching, SiO₂ is oxidized to form silicon tetrafluoride (SiF₄). Silicon dioxide can also be etched with basic hydroxide salts such as NaOH forming sodium silicate Na₂SiO₃ but only at extremely high temperatures. Since HF is not normally present in an fuel cell and operating temperatures are limited, then silicon based molecules are well suited as permanent fillers in the acidic environment of proton exchange membrane (PEM).

Silica can also form ionized molecules known as silicates. As the quadrivalent anion of silica, silicates invariably form a wide variety of larger molecules, often structurally in the form of crystals, clusters, rings, and chains, containing strong high temperature bonds. These atomically bound quasi-crystals may in turn, maintain a net charge, typically negative, able to participate in ion exchange reactions with protons and cations.

Replacing some silicon atoms in the three-dimensional superstructure of silicon dioxide by aluminum atoms, forms aluminosilicate known as zeolite. As a subclass of silicates, zeolite combining quadrivalent silicate anion [SiO]⁴⁻ and the pentavalent aluminate anion [AlO4]⁵⁻ together forming the silicate superstructure zeolite ([M]⁺)(AlO₂⁻)(SiO₂)ₓ(yH₂O) where the metallic-ion [M]⁺ may comprise monovalent cations such as H⁺, Na⁺, and K⁺; or divalent cations including Mg²⁺ and Ca²⁺. Examples of zeolite compounds include Na₂ Al₂Si₂O₈·yH₂O, and the naturally occurring minerals gemelinite Na₂Ca(AlO₂)₂(SiO₂)₄·6H₂O and erionite Na₂K₂CaMg(AlO₂)₂(SiO₂)₂·6H₂O.

Because of the presence covalently bound aluminum, zeolite is mechanically strong yet having an electrochemical behavior more metal-like than silicates. It is thereby are used in numerous industrial applications involving ion exchange or as a reaction catalyst, particularly in the processes of cracking, isomerization and hydrocarbon synthesis common in the fossil fuel and petrochemical industries. Because of structural integrity, zeolite makes a good candidate as a permanent filler in a proton or anion exchange membrane, a relatively benign environment compared to its usual applications.

As depicted previously in FIG. 433B, both silicates and zeolites are able to form hollow spherical crystals or nanocrystals. The Swiss-cheese-like crystalline structure, referred to as mesopores or mesostructures, is chemically and electrically beneficial as it increases the reactive surface area of the nanosphere while affording the possibility to capture guest molecules like acid or aluminum within its confines. Representative examples made in accordance with this invention include mesostructured cellular foam (MCF) 6431, hollow mesoporous silica nanospheres 6430 with phosphorus based acid guest molecules such as phosphonic or phosphoric acid; and mesoporous silica honeycombs 6432 containing aluminum grafted guest molecules.

Formation of silica base nanoparticles may include a number of processes, the most widely of which include spherical colloidal silica systems using the seeded growth of nanoparticles as developed by Stöber; using amino acid-catalyzed (AAC) methods; or by employing water-in-oil reverse microemulsion (WORM). Since silica and silicate nanoparticle synthesis are well established, the processes for their formation will not be further elaborated herein.

As one embodiment of this invention the combination of a stable covalently-bonded silica molecule matrix with high surface density contain immobile reactants such as acids or metals enables the silicate mesostructure to contribute to conduction and catalytic activity without compromising the structural integrity of the silicate permanent filler.

Similarly zeolite made in accordance with this invention include the zeolite nanocluster 6480 and self-forming zeolitic imidazolate framework (ZIF) 6481, in the example shown bonded to a polybenzimidazole (PBI) skeleton. Like the aforementioned silicate mesostructures the zeolites offer a stable exoskeletal structure with large surface area and the opportunity to host reactive species within the structure such as a metal catalyst atom shown previously in zeolite nanocluster 2334 in FIG. 349.

Beneficial uses of IEM permanent fillers comprising silicates and zeolites made in accordance with this invention include enhanced ionic conductivity achieved by through the additional pathways for ion transport provided by the permanent filler and by the release of additional charge carriers such as protons donated into solution by ionization of silicate-bound or zeolite-bound immobile acids. In this sense, the nanoparticles act as extra ionomers but do not interfere with the structural integrity of the inert hydrophobic polymer forming the backbone of the membrane. Like carbon nanotubes, silicates and zeolites are able to enhance IEM conduction by creating a denser concentration of immobile anions and mobile cations, but without the added challenge of pretreating its surface to facilitate bonding to the polymeric matrix the way the inert surfaces of CNTs require.

Other benefits of silicates and zeolites include reinforcing the membrane structure, enhancing its tensile strength and flexibility by creating cross linking bonds to adjacent polymer backbones otherwise not secured to one another. In this manner the fillers improve the microstructure of the membrane by creating a more uniform and interconnected network. Moreover since silicon and oxygen form high energy covalent bonds 6.7 eV (640 kJ/mol), the dissociation temperature is very high, in the range of 600 to 800° C. As this temperature is an order-of-magnitude hotter than the operating temperature of the membrane, the inclusion of silicate and zeolite permanent fillers into a membrane cast or mold prior to polymerization improves the temperature stability of the film, i.e. enabling the membrane to withstand higher temperatures without degradation or leakage. Similarly because of these high energy bonds, silicate and zeolite fillers are impervious to acids, bases, and solvents, thereby improving the chemical resistance of the membrane.

Overall, the addition of silicates and zeolites into an ion exchange membrane made in accordance with this invention improve the magnitude and selectivity of ion transport, reducing crossover, enhancing efficiency, and reducing waste heat. When added into the CCM catalyst layer or an optional membrane nanocoating, the presence of the silicates and zeolites can improved interfacial charge transfer, enhance catalysis, and provide added protection against the diffusion of gaseous environmental toxins such as nitric oxide (NO) otherwise able to damage or disable catalytic metals.

### Zirconium, Tungsten & Transition Metals (TMs):

As depicted in the abridged periodic table of the elements shown in FIG. 327, elements zirconium (Zr) with atomic number 40 and tungsten (W) with atomic number 74 are transition metals with d-block orbitals. Specifically, zirconium with an atomic structure [Kr]4d² 5s² has two electrons in its d-shell and two more in its outer s orbital. The two electrons can occupy any two of the five possible d-orbitals, namely

d_{xy},d_{yz},d_{zx}, dₓ_{²}_{-y}_{²},d_{z}_{²}

enabling it to form bonds with various ligands, whereby the zirconium d-orbitals split into multi-levels forming complex bonds with ligands in a manner similar to the mechanisms described previously for a metal-organic-frameworks (MOFs). The d-orbitals also can split enabling the formation of metallic crystals and quasi-crystals, as well as forming various bonds chemical bonds with other compounds and with the polymeric matrix. Because of an ability for electrons in its an unfilled 4^{th} shell to change orbitals, zirconium that can participate in bonding, electronic transitions, and catalytic reactions. Examples of zirconium forming various electronic configurations as shown include intercalated zirconium 6450, zirconium nanospheres 6451, and zirconium oxide (ZrO₂) 6452.

Specifically, tungsten (W) with an atomic structure {(Xe)4f¹⁴5d⁴6s²} contains a filled penultimate shell of 14 electrons, along with four valance electrons in its d-shell, and two more valance electrons in its outer s orbital. The four electrons in the fifth shell can occupy and two of the five possible d-orbitals described previously. This versatile electronic configuration enables tungsten to engage in conduction, catalysis, bonding, and crystallization like zirconium but with a higher density of free electrons. As such, tungsten compounds properly constructed in accordance with this invention exhibit higher conductivity, better ionomeric charge exchange efficiencies, and enhanced charge transport over that of zirconium.

Exemplary molecules demonstrating the versatility of tungsten made in accordance with this invention include tungsten carbide (WC), tungsten nanoparticles 6471, and phosphotungstic acid 6470. Tungsten has a high density of free electrons, which contributes to its excellent electrical conductivity. Additionally, tungsten has a high melting point and is often used in applications requiring stable and efficient electrical conduction at high temperatures. As such, tungsten molecules made in accordance with this invention when included within a polymeric membrane improves conductivity and mechanical strength of the film.

Aside from enhancing conductivity and providing structural support molecules, metals, metal-oxides and metallic quasi-crystals comprising transition metals also function as catalysts useful in the synthesis of ion exchange membranes and as electrochemical components in the CCM in the operation of a fuel cell or an ionic filter membrane. For example, as a catalyst zirconium is used for polymerizing alkenes to produce polyethylene and polypropylene, a part of membrane synthesis. Tungsten is also well known for its catalytic properties, especially in reactions involving hydrogenation, dehydrogenation, and other chemical processes. Tungsten's catalytic activity is often enhanced when it is in the form of tungsten carbide (WC). This form is particularly useful in industrial applications such as hydrocracking but may also be applied to ionic membrane filtering.

In the context of this application, the catalytic properties of tungsten, zirconium, and other catalytic metals can be used in a variety of ways, either in the catalyst layers of a CCM, in nanocoatings of the ionomeric membrane, or within the ionomeric membrane itself. For example, in one set of embodiments a zirconium nanocluster or tungsten quasi-crystal such as tungsten carbide (WC) is introduced into an ion exchange membrane as a permanent filler during synthesis. The role of these membrane permanent fillers within the polymeric matrix is not only to enhance conductivity by increasing the density and number of charge transport pathways to reduce tortuosity, but to secondarily function as a safeguard for reducing fuel crossover. In this function, stray hydrogen escaping the catalyst in the anode and diffusing into the membrane encounters the catalytic permanent filler which converts the hydrogen into protons and electrons thereby increasing the conversion efficiency and reducing risk of hydrogen peroxide formation in the cathode.

In yet another embodiment, permanent fillers of zirconium and tungsten compounds are added into a nanocoating deposited on the cathode side of the membrane. In this case the catalysts are used to sequester or dissociate environmental gaseous toxins such as carbon monoxide (NO) present in the oxygen supply, generally contained within atmospheric air used as the oxygen source in open cathode fuel cells.

In other embodiments of this invention, zirconium, tungsten or other transition metal (TM) compounds are used in the catalyst coated membrane (CCM), also known as the membrane electrode assembly MEA3. The addition of the transition metal catalyst into the catalyst layer (CL) promotes more efficient proton generation from hydrogen or methanol in the anode catalyst layer (ACL), a reaction referred to as the hydrogen oxidation reaction (HOR) or hydrogen evolution reaction (HER). For HOR reactions, catalytic efficacy depends on a catalysts metal's ability to adsorb and dissociate hydrogen molecules and facilitate the transfer of protons and electrons. As tungsten in the form of tungsten carbide (WC) exhibits hydrogen catalytic properties similar to platinum, WC is particularly effective in HER due to its ability to adsorb hydrogen and facilitate proton generation.

The oxygen reduction reaction (ORR) at the cathode of a proton exchange membrane fuel cell (PEMFC) is a key reaction determining the overall efficiency and performance of the fuel cell. Catalysts are crucial for enhancing the efficiency of this reaction. Since the HOR reaction and ORR are complementary reactions in a REDOX reaction pair, the optimum catalyst metal is not necessarily the same. Traditionally, platinum (Pt) has been the most effective catalyst for both HER and especially for ORR due to its high activity and stability. However, due to the high cost and scarcity of platinum, alternative catalysts or enhancing the performance of platinum by combining it with other metals are now needed.

More generally any non-radioactive non-corrosive transition metal may be used in the catalyst layer of a fuel cell. As described for zirconium and tungsten above and previously in the section on metal organic frameworks (MOFs), transition metals also known as d-block elements are good candidates as catalysts for a variety of reasons including their (i) availability of vacant d-orbitals in an unfilled shell; (ii) ability to manifest various oxidation states; (iii) ability to form transition states in the chemical reaction; and (iv) ability to form complex compounds with the ligands.

Alternative transition metals described herein include nickel, copper, chromium, cobalt, tungsten, and the abundant elements of iron along with titanium, manganese, zirconium, vanadium, and chromium. Like platinum, the precious metals of gold, silver, platinum, and palladium are rare and therefore more costly.

In one embodiment of the invention, platinum catalysts in the ACL and/or the CCL are replaced with platinum alloys of platinum-cobalt (Pt—Co); platinum-nickel (Pt—Ni); and platinum-iron (Pt—Fe). Non-platinum catalysts made in accordance with this invention comprise transition metal-nitrogen-carbon (TM-N—C) catalysts coordinated with nitrogen and embedded in a carbon matrix including exemplary metal compounds such as iron (Fe—N—C) or cobalt (Co—N—C). In another embodiment the catalysts comprise metal oxides such as manganese oxide (MnO₂), cobalt oxide (Co₃O₄), iron oxide (Fe₃O₄), and titanium dioxide (TiO₂).

As an embodiment of this invention to enhance catalytic activity, especially for the oxygen reduction reaction (ORR) in the cathode catalyst layer (CCL), tungsten carbide (WC) is included either as a primary catalyst or as a co-catalyst used in conjunction with platinum or metal-nitride, or metal-oxide compounds intermixed within in a carbon matrix. WC is advantageous as it emulates many platinum like characteristics including conductance, structural integrity, thermal and chemical stability, but at substantially lower cost.

In another set of embodiments zirconium is included in the catalyst layer, not as a primary catalyst but as a co-catalyst. Doping pure zirconium into transition metal (TM) catalysts can improve the overall mechanical stability and electronic properties of the catalyst layer while enhancing dispersion and uniformity of the active sites. Zirconium doping of WC stabilizes the carbide phase, preventing the formation of undesirable oxide layers that could deactivate the catalyst. Zirconium also enhances resistance to corrosion and oxidation, extending the catalyst's operational lifespan. Together, Zr-WC exhibits modified surface properties such as increased surface area, increased active site density, and better adsorption and activation of oxygen molecules, important for efficient oxygen reduction reactions.

In another embodiment zirconium oxide (ZrO₂) is added to support for platinum or other transition metals, providing stability and enhancing the dispersion of the catalytic particles. Alternatively, incorporation of ZrO₂ into tungsten carbide provides a high surface area support structure for WC nanoparticles, enhancing the surface area and maximizing the number of active sites available for ORR. The strong interactions between ZrO₂ and WC also enhance the stability of the catalyst, preventing aggregation and sintering of tungsten carbide nanoparticles under operational conditions while enhancing catalysis. ZrO₂, known for its excellent chemical stability and resistance to acidic and basic environments, thereby protects the active WC catalyst sites from harsh conditions often encountered in fuel cells and other electrochemical systems, prolonging the catalyst's life. Moreover, ZrO₂ has a high oxygen storage capacity facilitating a steady supply of oxygen to the active catalytic sites during the ORR.

### Metal-Organic-Frameworks:

Made in accordance with this invention metal organic frameworks (MOFs) such as exemplary MOF quasi crystals 6460, zirconium metal clusters 6461, metal clusters 6462, and MOF prisms and lattices 6463 shown in FIG. 433B form an entire array of metallic dopant applicable as permanent fillers within an ionomeric polymer membrane, as catalysts in CCM catalyst layers, and as toxic scavengers within membrane nanocoatings. Functionalization of MOFs include chemically active sites on the vertices of the matrix 2134 shown in FIG. 319, as functional groups 2104 attached via sidechains to organic ligands shown in FIG. 313, or via guest molecules 2112 captive within the matrix as shown in FIG. 316.

In accordance with this invention the elements controlling conduction, chemical bonding, and catalytic activity can be independently selected or even combined within the same MOF. For example a MOF used as a permanent filler in an IEM or PEM can include ionomeric groups or acids to enhance conductivity, but can also include catalyst used to suppress fuel crossover. Alternatively a nanocoating may include MOFs containing both scavenger metals preventing nitric oxide (NO) poisoning and active catalyst metals such as platinum to enhance reaction rates and conversion efficiency.

### Nanostructures:

Made in accordance with this invention, various nanostructures are employed to modify the structure, stoichiometry, porosity, chemical reactivity, mechanical strength, durability, thermal resistance, electrical conductivity, and other material properties. Various embodiments of nanostructures used as permanent fillers made in accordance with this invention as depicted in FIG. 433B. Examples include nanofibers 6440 introduced into the polymeric matrix to provide enhanced structural rigidity and strength and to improve thermal conductivity; coated composites 6441 which may used as a permanent filler or form ionomeric membranes directly; and metal oxide nanoparticles 6442 which may be coated on a membrane or included within the mold as a permanent membrane filler. Other nanostructures include metal nanoclusters, PMMA nanospheres, and nano-barriers.

All the nanostructures described herein may be added into the polymer matrix during molding as permanent fillers; may be used as a component of membrane nanocoatings; or may be an additive to CCM catalyst layers. These nanostructures may be applied separately or combined with skeletal membrane support, the sacrificial pore process, with any other permanent filler. They may included in homo-ionomer and hetero-ionomer films comprising any described polymer, hybrid polymer, copolymer, or block polymer.

Nanofibers (NF)—Made in accordance with this invention, one class of nanostructure is a nanofibers may be used to directly form a membrane or may be used to as a permanent filler within a membrane comprising a copolymer The nanofibers may form a entangled web with a copolymer whereby material strength is increased even if the two polymers do not chemically bond to one another. In another embodiment the nanofibers 2401 are fabricated using electrospinning and subsequently gently crushed 2402 to reduce the average length of the nanofibers 2401m before loading them into the mold for casting as depicted in FIG. 372.

This sequence controls the average length of the fibers to prevent their protrusion from the molded film without crushing them so finely they change into a powder. Made in accordance with this invention polymers able to form reasonably strong extruded or electrospun fibers including polyurethane (PU); polypropylene (PP); polyimide (PI); and poly(ethylene terephthalate) (PET). Other polymers such as polystyrene (PS); polyvinylidene chloride (PVDC); poly(methyl methacrylate) (PMMA); and polycarbonate (PC); while able to be functionalized by ionomeric groups do not form strong flexible nanofibers and are less adaptable for extrusion or electrospinning processes.

Polyurethanes (PU) offer excellent mechanical properties able to form strong extruded or electrospun fibers in textiles and gauze, medical devices, and elastomers. As described previously polyurethanes can be functionalized by incorporating ionomeric groups by modifying the polymer backbone or by adding functional groups during the polymerization process.

Polypropylene (PP) comprises strong nonwoven fibers with good tensile strength and chemical resistance. Polypropylene however is relatively inert and nonpolar, making it challenging to functionalize with ionomeric groups after synthesis except by grafting techniques. Other PP as described previously must be functionalized by blending with co polymers that contain ionomeric groups.

Polyimides (PI) offer excellent thermal stability and mechanical properties able to form strong nanofibers applicable for high-performance applications such as aerospace and electronics. Polyimides as described herein can be functionalized by incorporating ionomeric groups during the polymerization process using monomers that contain functional groups or in subsequent processing by post-polymerization modification.

Poly(ethylene terephthalate) (PET) is a thermoplastic polymer offering excellent mechanical properties and chemical resistance able to produce fibers for textiles, such as polyester fabrics, and for industrial applications like tire cords. Made in accordance with this invention PET can be adapted for nanofiber based membranes and permanent fillers via functionalizing it during copolymerizing with monomers that contain ionomeric groups or alternatively by surface modification techniques, enhancing its conductivity, adhesion properties, and compatibility with other materials.

While many polymers can be polymerized by a casting process into a thin membrane and functionalized by ionomeric groups, far fewer polymers are well suited for extrusion or electrospinning to form nanofibers. For example, polycarbonate (PC) offers high impact resistance and optical clarity. While not well suited to form fibers, it is still well suited for applications such as eyewear lenses, automotive components, and electronic devices including quasi rigid membranes in high temperature fuel cells. Polycarbonate can be functionalized by incorporating ionomeric groups during its molding process. Poly(methyl methacrylate) (PMMA), also known as acrylic, is a transparent thermoplastic often used as a lightweight and shatter-resistant alternative to glass. Although it can form fibers it is better suited for applications such as optical devices, lenses, and displays. Nonetheless PMMA can be functionalized by copolymerizing with monomers that contain ionomeric groups or by surface modification techniques, enhancing its material properties such as improving its adhesion to other materials or increasing its hydrophilicity.

Polyvinylidene chloride (PVDC) is beneficial for its barrier properties and not as useful to form strong flexible fibers but is still applicable in rigid filter membranes. PVDC can be functionalized by copolymerizing with other monomers that contain ionomeric groups thereby improving its compatibility with other materials and enhance its properties for specific applications. Another polymer, polystyrene (PS) is generally brittle and does not form strong fibers. It is more commonly used in applications where rigidity is required, such as packaging and insulation. Although polystyrene can be functionalized it requires steps involving sulfonation or by copolymerizing it with other monomers that contain ionomeric groups. For example as shown in poly sulfonated polystyrene nanofiber (P(sPS) NF) matrix 2035 in FIG. 304.

Coated Composites—In another class embodiments involving nanostructuring, polymer nanofibers (NF) 6461 shown in FIG. 433B are coated with a nanocoating to alter in surface properties, wettability, and conductivity. The fibers are first synthesized by extrusion such as electrospinning, by precipitation of colloidal suspensions, or by stretch-expansion process as exemplified by extended polytetrafluoroethylene (ePTFE). Nanofibers may include graphene nanofibers (GNs); graphene oxides (GO); polystyrene; poly(I)-lactide (PLLA); poly(vinylidene fluoride) (PVDF); polyacrylonitrile (PAN); poly(vinyl alcohol) (PVA), chitin; PVA-chitosan; gelatin, polycaprolactone (PCL); PCL-gelatin; polylactic acid (PLA); silk; and the corn-protein zein.

After synthesis, the fibers are coated by various beneficial materials including a nanoparticle slurry of PTFE and PFSA molecules, by alloys or oxides of transition metals and catalysts such as platinum, by cross linkers and molecular glues such as glutaraldehyde, by polymer bonding agents such as polydopamine and reduced graphene oxide (rGO), or by various ligands. Coating may be performed by soaking the fibers in a liquid suspension; by deposition using sputtering or chemical vapor deposition (CVD); or by ultrasonic spray coating. Subsequent annealing depends on the materials employed where molding and cross linking of the nanofibers may precede the coating process or be performed after coating.

For example if the coating includes a suspension of PFSA and PTFE nanoparticles, subsequent thermal processing may be performed at a higher temperature used in polymerization and cross linking reactions, e.g. between 125° C. and 250° C. In other applications, the coating is only dried generally at temperatures between 25° C. and 60° C. While the nanocoating may comprise catalytic or ionomeric functional groups, in biofilters it may also include polydopamine (PDA) to improve biocompatibility of graphene nanofibers (GNs) or include antibacterial coatings such as tetracycline hydrochloride.

In one embodiment chitin nanofiber modified by surface modification with polydopamine produces nanofiber-polydopamine composite able to remove dyes such as methyl blue and various metals such as Fe³⁺, Mn²⁺, Cu²⁺, and Ni²⁺ from wastewater. In one embodiment the filter membrane is reinforced by the endoskeleton described herein to provide added mechanical support. Other nanocomposites 1964 in FIG. 294 may comprise nanospheres (NS) rather than nanofibers.

Metal & Metal-Oxide Nanoparticles (NPs)—In another set of embodiments made in accordance with this invention metal or metal oxide nanoparticles 6442 are included either discretely as permanent fillers loaded in the membrane prior to molding or attached to carbon nanotubes. Examples shown previously in FIG. 297B include platinum amino functionalized nanoparticles (Pt—NH₂ NP) 1989a and titanium amino functionalized nanoparticle (Ti—NH₂ NP) 1989b, along with titanium tin functionalized nanoparticle (Pt—Sn NP) 1992 in FIG. 298, silver (Ag nanoparticles 2035 shown in FIG. 306A, and zirconium oxide nanospheres (ZrO₂ NS) 2084 in FIG. 311. Other metal clusters include chromium terephthalate metal cluster (MIL-101(Cr)) 2153 shown previously in FIG. 322; tungsten carbide (WC) nanoparticles 2255 in FIG. 335; metal-sulfur complex 2332 in FIG. 349; platinum titanium dioxide nanoparticles (Pt-TiO₂ NP) 2357 in FIG. 360.

PMMA Nanospheres—Aside from its role as a polymer, poly(methyl methacrylate) is also able to form nanospheres (PMMA NS) 1723 described in FIG. 249. PMMA nanospheres can improve the proton conductivity of PEMs. Their incorporation create multiple pathways that facilitate the movement of protons, thereby reducing the charge transport tortuosity enhancing the overall conductivity of the membrane.

The addition of PMMA nanospheres made in accordance with this invention also enhances the mechanical strength and durability of PEMs. This is particularly important for the longevity and reliability of fuel cells often subjected to harsh operating conditions. PMMA nanospheres as described increase the thermal stability of PEMs rendering membranes more resistant to degradation at higher temperatures which is beneficial for fuel cell performance and lifespan. In direct methanol fuel cells (DMFCs), PMMA nanospheres help reduce methanol crossover from the anode to the cathode, crucial for maintaining the efficiency and performance of the fuel cell.

PMMA nanospheres made in accordance with this invention also enhance the water retention capabilities of PEMs. Proper hydration is essential for maintaining high proton conductivity. PMMA nanospheres help retain water within the membrane, especially under low-humidity conditions. PMMA nanospheres can be easily functionalized with various chemical groups. This allows for the tailoring of the membrane properties to meet specific requirements, such as enhancing compatibility with other membrane components or improving specific performance metrics. PMMA nanospheres can be uniformly dispersed within the polymer matrix of the PEM. This uniform distribution helps in achieving consistent performance across the entire membrane, preventing localized weaknesses or failures. Moreover, PMMA nanospheres are chemically stable and resistant to various chemical environments. This stability ensures that the PEM maintains its integrity and performance over time, even in the presence of reactive species. And because PMMA is relatively inexpensive compared to other nanomaterials incorporating PMMA nanospheres into PEMs offers a cost-effective way to enhance ionomeric properties without significantly increasing the overall cost of the fuel cell.

Examples of PPMA nanosphere used as permanent fillers include sulfonated poly(methyl methacrylate) (sPMMA) 1745 in FIG. 253 and surface functionalized PMMA nanosphere 1748 in FIG. 254. In other embodiments, PMMA forms a porous nanosphere 1763 in FIG. 255 and a PMMA nanocluster 1773s in FIG. 256A containing ZnS nanospheres. Another variant PMMA nanocluster 1773so in FIG. 256B containing zinc-oxide (ZnO) nanospheres.

Nano-barrier—In one embodiment of this invention shown in FIG. 398, polydopamine 2565a and ADPS 2565b are used a fillers to create a nano-barrier against methane 2526 transport but not against proton conduction. ADPS is the compound 3-(3-aminopropyl) dimethylammonio) propane-1-sulfonateare

### Polyhedral Silsesquioxanes:

Another category permanent filler made in accordance with this invention comprises polyoctahedral and double decker silsesquioxanes POSS 6490 and DDSQ 6491 shown in FIG. 433B. Polyoctahedral and double-decker Silsesquioxanes are types of polyhedral oligomeric silsesquioxanes (POSS), which are nanostructured chemicals that have unique properties making them beneficial in various applications, including proton exchange membranes (PEMs).

For one thing, POSS and DDSQ are hydrophilic improving hydration and correspondingly enhancing conductivity. The presence of hydrophilic groups also create more pathways for proton transport and reduce the tortuosity of conduction pathways. The nanoscale dispersion of POSS within the polymer matrix also forms well-defined proton-conducting channels, further improving the overall conductivity of the membrane. Proper water management is essential to prevent membrane dehydration and ensure stable operation.

In another embodiment of this invention, the addition of POSS and DDSQ and permanent fillers enhance the film's mechanical properties including durability, strength, thermal, and chemical stability. The incorporation of POSS into PEMs significantly enhances a membrane's mechanical strength and durability due to the rigid cage-like structure of POSS, which reinforces the polymer matrix. POSS molecules also improves the thermal stability of PEMs, making them more resistant to high temperatures important for efficient operation of fuel cells. POSS also improves the chemical stability of PEMs by providing resistance to oxidative and hydrolytic degradation important in the harsh operating environments of fuel cells, where the membrane is constantly exposed to reactive species. By enhancing the chemical stability, POSS-modified PEMs achieve longer operational lifespans, improving reliability in mission critical applications, reducing the frequency of membrane replacement, and lowering overall maintenance costs.

In general, POSS molecules can be functionalized with various organic groups, allowing for the customization of the PEMs' properties to suit specific applications. This functionalization can be used to optimize proton conductivity, mechanical properties, and compatibility with other components of the fuel cell. The ability to tailor the properties of POSS-modified PEMs makes them versatile for different types of fuel cells, including those operating at different temperatures and humidity levels.

### Ionic Liquids.

If a cation or anion is mobile, it modulates the conductivity of any material in which it is introduced. Rather than relying on ionization of membrane acids, mobile ionic charges are introduced into membranes by infusing the material with ‘ionic liquid’. Ionic liquids are ionic salts, typically with an organic compound forming a cation and a halogen as anion. Since ionic liquids include both a positively charged cation [IL_{c}]⁺ and a negatively charged anion [ILₐ]⁻, the introduction of an ionic liquid into a ion exchange membrane improves the conductivity of both PEM and AEM types, a topic discussed in the following section

Specifically to enhance proton conduction in a proton exchange membrane (PEM) also known as a cation exchange membrane, the cations [IL_{c}]⁺ present in an ionic liquid used to dope a PEM film increases the concentration of positively charge ions in the matrix thereby enhancing conductivity. The added charge density reduces the film's resistivity across the spectrum of usable current densities, improving conductance and conversion efficiency without provoking a commensurately proportional increase in hydration and membrane swelling. Ionomeric polymer membranes doped with ionic liquids enhance proton density and improve conductivity. For IL doping of proton exchange layers, the magnitude of conductivity modulation depends on the concentration of IL doping and on the chemical species of the IL cation compound but not on the anion composition. A sample of possible IL cations able to be complexed in ionic salt precursors of various ILs include a variety of species depicted in FIG. 433C.

Ionic liquid cation include cyclic rings with single radical extensions pyridinium 2632 and thiazolium 2636. Pyridinium 2532 comprises an aromatic conjugate acid of pyridine and ionic liquid cation having the chemical formulation [C₅H₅NH]⁺ abbreviated as [Pyr]⁺. Thiazolium 2636 comprises a protonated form of thiazole, a 5-membered heterocyclic sulfur-nitrogen compound and ionic liquid cation having the chemical formula [C₃H₄NS]⁺ and abbreviation [Tz]⁺.

ILs comprising diradical extensions from a cyclic ring include imidazolium 2630, pyrrolidinium 2631, and piperidinium 2637. Imidazolium 2630 comprises a protonated form of an organic aromatic heterocycle imidazole and ionic liquid cation with a chemical composition [C₃N₂H₃]⁺ abbreviated as [Im]⁺. Pyrrolidinium 2631 comprises a protonated form of organic amine heterocycle pyrrolidine and ionic liquid cation having a chemical formulation [(CH₂)₄NH₂]⁺ and the abbreviation [Pyrr]⁺. Piperidinium 2637 comprises a protonated form of the heterocyclic methylated amine piperidine and ionic liquid cation having the chemical formulation [C₅H₁₂N]⁺ abbreviated as [PipH]⁺.

A triradical IL with a central core is sulfonium 2635. Sulfonium comprises a positively charged organosulfur compound and ionic liquid cation with a chemical formula [SR₃]⁺ comprising three organic substituents R attached to a central sulfur core.

Tetrahedral ILs include ammonium 2663a, quaternary ammonium 2663b, and phosphonium 2634. The subclass ammonium comprises a positively charged polyatomic ion of ammonia and ionic liquid cation 2663a having the chemical formulas [NH₄]⁺ or as a quaternary ammonium cation 2663b with the form [NR₄]⁺ where R represents one or more hydrogen atoms replaced by organic groups or other compounds. Phosphonium comprises a positively-charged tetrahedral polyatomic ion and ionic liquid cation having the chemical formula [NR₄]⁺ where R represents a hydrogen atone or an alkyl, aryl, or halide group.

Protonated hydrocarbons (carbonium cations) comprise a broad class of positively charged protonated hydrocarbon solvents and ionic liquid cations referred to collectively as alkali carbonium aka alkanium 2638 including methanium, protonated methanol, ethanium, protonated ethanol, propanium, protonated propanol, butanium, protonated butanol, octonium, protonated acetone, protonated acetonitrile, protonated dimethyl sulfoxide [(DMSO)H]⁺, protonated toluene, protonated aniline, and others.

Biochemical cations comprise a diverse class of positively-charged and protonated organic compounds formed by or participating in biochemical reactions including carbonium (described above) and protonated choline, aka cholinium 2639 along with protonated creatine, protonated arginine, protonated lysine, protonated histidine, etc.

Other ionic liquids include superbase cations result from superbase reactions where a strong base such as ammonium, phosphonium, sulfonium, phosphazene, amidine, guanidine, and other onium ions becomes protonated forming IL pairs or releasing the sequestered protons thereby influencing ionic conductivity.; and,

Poly ionic liquids comprising copolymers of ionic salts exemplified by vinyl functionalized imidazolium and by vinyl pyrrolidinium 2640 including numerous variants mirroring those of their fundamental cation radical offer added control over ionomeric conductivity, thermal stability, and changing hydration.

Many but not all cations of ionic liquids comprise onium ions representing a broad class of cations derived from neutral molecules through the addition of a proton (H⁺) or other cations. Onium ions contain a central atom, often of nitrogen, phosphorus, sulfur, or oxygen, carrying a positive charge. Of the foregoing, some cationic superbases are onium ions, but not all superbases are onium ions.

In one embodiment shown in FIG. 422B, any of the ionic liquids may be introduced into a membrane and sealed from leakage laterally by the inert skeletal pillars and sealed from the gas diffusion layer by a nanocoating as depicted in FIG. 422C or by a catalyst layer designed to prevent IL seepage.

### IEM Applications.

The applications of the foregoing inventions are nearly unlimited including primary power generation for fixed infrastructure such the power grid; for locally generated power for residences, offices, factories and hospitals; and in mobile power solutions for vehicular power in transportation including electric powered cars, trucks, trains, airplanes, and drones. Other mobile applications include portable generators, remote location power, and ad hoc emergency power networks.

Embodiments made in accordance with this invention include the individual elements of a fuel cell or electrolysis system, the processes used to fabricate the elements, the inventive benefits of combining these elements into a energy conversion device such as a fuel cell or electrolysis system, and the augmentation of an energy conversion device to store electrical charge as part of the energy conversion process. Examples of buffer augmented energy conversion devices made in accordance with this application include for example, intelligent buffered fuel cells and buffered electrolysis systems.

Applications of the IEMs made in accordance with this invention include:
Fuel cells that convert a fuel source into electricity by the transport of positive charges such as hydrogen across an IEM membrane, and storing the generated electric charge in an electrical buffer comprising an array of super capacitors or electrochemical cells such as lithium ion or sodium ion batteries. IEMs that conduct positive ions across the membrane are referred to as proton exchange membranes having the acronym PEM or alternatively as cation exchange membranes.
Fuel cells that convert a fuel source into electricity by the transport of negative charge ionized molecules such as hydroxyl across an IEM membrane, and storing the generated electric charge in an electrical buffer comprising an array of super capacitors or electrochemical cells such as lithium ion or sodium ion batteries. IEMs that conduct negative ions across the membrane are referred to as anion exchange membranes having the acronym AEMs.
Electrolysis using electricity to convert a reactant such as water, methane, or glucose into a fuel source such as hydrogen by the transport of positive charges across an IEM membrane, where the electrolytic process is powered by a source of electrical power such as grid power, solar PV generated power, or from electric charge stored in an electrical buffer comprising an array of super capacitors or electrochemical cells such as lithium ion or sodium ion batteries. IEMs that conduct positive ions across the membrane are referred to as proton exchange membranes having the acronym PEM or alternatively called cation exchange membranes.
Electrolysis using electricity to convert a reactant such as alkaline solutions or potassium hydroxide into a fuel source such as hydrogen by the transport of negative charges such as hydroxyl ions across an IEM membrane, where the electrolytic process is powered by a source of electrical power such as grid power, solar PV generated power, or from electric charge stored in an electrical buffer comprising an array of super capacitors or electrochemical cells such as lithium ion or sodium ion batteries. IEMs that conduct negative ions across the membrane are referred to as anion exchange membranes having the acronym AEMs.
Electrodialysis, the process of electrochemical separation of ions in aqueous solutions using IEMs driven by the application of an electrical potential. Dialysis methods relying on IEM separation include Donnan dialysis, reverse electrodialysis, and electro-electrodialysis. Dialysis may used PEM proton exchange membranes or AEM anion exchange membranes (AEM) depending on the compounds being separated.
Electrochemical filtering, the process where an ionomeric filter membrane containing polymeric bound immobile anion or cation groups along with various catalysts is used to remove pollutants including particulates, solvents, metals, heavy metals, salts, and other contaminants from water or from wastewater. Electrochemical filtering is an important process in wastewater management and water recycling.
Desalination, the process where an ionomeric filter membrane is used to attract, capture and ultimately remove salts from seawater in order to produce fresh water.
Deionization, the process where ionized salts and organics are removed from water using an ionomeric filter membrane containing polymeric bound immobile anion or cation groups along with various catalysts. Deionized water is the reactant used for hydrolysis of water into hydrogen.

### Buffered Fuel Cell.

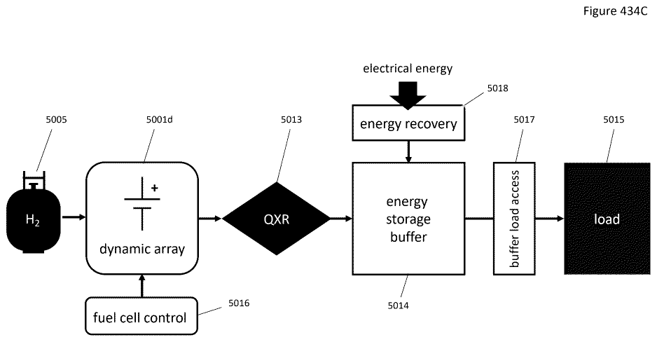

In contrast to a conventional fuel cell, inventive benefits of the buffered fuel cell made in according with this invention is its ability to decouple, i.e. isolate the electrical performance of a fuel cell from electrical loads it powers. Instead, the electrical load 5015 draws its power from the electrical energy storage buffer 5104, and the fuel cell shown here as a fixed array 5001 supplies power to charge and refresh the buffer by converting fuel 5005 into electricity. The load does not however directly draw power from the fuel cell. Represented in a simplified schematic shown in FIG. 434A this buffered fuel cell function comprises a fixed array of fuel cells 5001 for converting hydrogen fuel 5005 into electricity which is transferred through charge transfer regulator to energy storage buffer 5014. The average power consumption for a home is 33 kWh of energy, roughly equivalent to the energy contained in one gallon of gasoline kilogram or one kilogram of hydrogen. The hydrogen may be stored in gaseous or liquid form or captured and held within a solid matrix of metal hydrides or metal-organic-frameworks (MOFs)

Electrical load 5015 in turn draws its power from energy storage buffer 5014. In this manner energy is passed through the buffer, allowing the charging current and charging rate of the buffer to be lower than the load current and slower than the buffer's discharge rate. During rapid load transients the lower impedance electrical storage is nearly able to supply current to the load while the recharging of the depleted charge is slower because of the higher impedance of the fuel cell. This phase delay means the majority of the electricity formed in the fuel cell is not supplied directly to the electrical load but instead flows through the electrochemical cell. For example a PEM may exhibit 1.2Ω of electrical resistance per cm² of active membrane area, i.e. having a specific resistance of [R_{FC} A_{FC}]=1200 mΩcm². Current densities of PFSA membrane based hydrogen fuel cells range from [I_{FC}/A_{FC}]=200 mA/cm² to 1000 mA/cm² not counting for thermal limitations.

In contrast, a lithium ion battery in an 18650 form factor comprises a cylindrical cell with a radii of 0.9 cm and a circular cross sectional area of 2.5 cm² with a typical resistance of R_{bat}≤50 mΩ for a specific resistance of [R_{bat} Aₓₛ]=120 mΩcm², having specific resistances roughly one order-of-magnitude lower than fuel cells. Operating at a nominal current of I_{bat}≈3000 mA, the current density of the electrochemical cell is approximately [I_{bat}/Aₓₛ]=(3000 mA)/(2.5 cm²)=1200 mA/cm², 20% higher than the highest fuel cell current density running hot, i.e. generating significant heat, and roughly 6× the current density of a fuel cell running in cool mode, i.e. at current densities of 200 mA/cm². From an application perspective this comparison is meaningful volumetrically as the cross section area Aₓₛ of a battery is analogous to the surface area of the fuel cell A_{FC}. Electrochemically however, the comparison is not accurate as the true surface area of the separator is not 2.5 cm² but approximately 2000 cm² comprising a 20 μm thick film rolled up into a tubular shape over one hundred times to fit within the battery's cylindrical can.

So long that the buffer doesn't become fully depleted during a high-current load condition, then on-average the buffer will recover during intervals where the load current is lower allowing replacement of the lost charge. In this sense the buffered fuel cell comprises two half circuits with different impedances—the high impedance loop formed by the fuel cell array 5001, QXR charge transfer regulator 5013, and energy storage buffer 5014; and a second low impedance loop formed between energy storage buffer 5014 and electrical load 5015.

To prevent damage to the fuel cell and energy buffer cells, certain protective functions are required. QXR charge transfer regulator 5013 performs necessary functions of (i) preventing excessive current draw from fixed fuel cell array 5001, (ii) preventing excessive charging currents into energy storage buffer 5014, and (iii) and preventing overcharging of the buffer resulting in an overvoltage condition on the buffer cells. The functions of QXR charge transfer regulator 5013 can be realized using discrete components, by combining current limiters with a voltage regulator, by employing current limited voltage regulators, or by adapting a battery charger. In essence, the QXR performs two duties—to ensure the fuel cell doesn't overdrive or overcharge the buffer and that the buffer doesn't draw more current than the fuel cell can reliably supply.

Overcharging a lithium battery by charging at too fast of a rate or charging to too high a voltage can result in excess heating, venting or leakage of its electrolyte, fire, or explosion. By contrast, drawing too much current from a fuel cell while capable of causing excess heating, is more limited by voltage sag, specifically where the fuel cell voltage drops dramatically above a certain current density. Although the physical mechanisms are many, the precipitous decline in a fuel cell's voltage is in part due to water logging in high-humidity environments and drying out under arid conditions

Aside from current limiting provided by QXR 5013, another method to reduce excess power dissipation in a fuel cell stack is to dynamically vary the electrical topology of the fuel cell stack. This advanced feature of a buffered fuel cell is to replace a fixed topology of fuel cell array 5001 with an electrically reconfigurable dynamic array 5001d as shown in FIG. 434B. In a dynamic fuel cell array, the number of fuel cells connected in series or in parallel can be altered during operation under control of the FCC fuel cell control 5016 function. In general, FCC fuel cell control 5016 senses the condition of the fuel cell to adjust it's the number of series connected cells n and the number of parallel connected cells m, thereby controlling the array's ‘msnp’ topology in real time.

Electrically the number of series connected cells ‘n’ determines the voltage of the fuel cell stack nV_{FC} where the voltage of a single fuel cell V_{FC} is a function of humidity, temperature, and current density. For example, if the voltage of the fuel cell stack in a dry climate drops too low to adequately charge a lithium ion battery, i.e. with a voltage nV_{FC}≥3.5V then additional cells can be connected in series to increase the stack voltage, e.g. by increasing from n=8 cells to n=10 cells.

Conversely, if the voltage of the fuel cell in a humid environment exceeds the maximum safe buffer overcharge voltage V_{OC}≥4.2V to a voltage higher than the ability of QXR charge transfer regulator 5013 to prevent overcharging the buffer cells, then the number of series connected fuel cells can be dynamically be reduced to a shorter stack, e.g. reducing the stack from n=8 to n=6. The FCC fuel cell control 5026 unit can perform this function simply by monitoring the fuel cell stack voltage either with a circuit comprising discrete comparators and ratioed voltage references, or using an A/D converter.

Operation of the FCC fuel cell control 5016 unit is described in greater detail in a related patent application “Intelligent Buffered Fuel Cell with Low Impedance” incorporated by reference herein. Rather than dynamically varying the number of individual active layers in a fuel cell, a more pragmatic method involves organizing the fuel cell stacks into groups called μstacks containing fewer layers, for example between 12 and 22 series connected membranes, and then to include or bypass some of the μstacks in the array depending on operating conditions.

In a similar manner the number of fuel cells ‘m’ connected in parallel can be adjusted to regulate the current output of the fuel cell stack. For example if the load 5015 is rapidly discharging energy buffer 5014 at a rate where the fuel cell cannot replenish, e.g. during operation in dry cold conditions then the current output capability can be increased by increasing the total width of operating fuel cells. If a fuel cell contains two stacks one with width m₁ and the other with m₂ then in the case of insufficient current both fuel cells can be dynamically activated charging the array topology from nsm₁p to ns(m₁+m₂)p and increasing the current from m₁l_{FC} to (m₁+m₂) I_{FC} where the fuel cell current per unit area I_{FC}=[I_{FC}/A]·mA_{FC} where [I_{FC}/A] is a design parameter for the fuel cells such as 200 mA/cm² and AFC is the area of a unit-cell fuel cell, e.g. 1 cm².

The sensory and decision making operations of FCC fuel cell control 1016 mean the buffered fuel cell is performing intelligent functions, and is therefore referred to as an intelligent buffered fuel cell or iBFC. The intelligence functions may be realized using dedicated electronic circuitry or reconfigurable logic including programmable logic array, microcontrollers, general processor units, or microprocessor based systems. The control algorithms may be stored as autonomous firmware without. dedicated operating system, or using software executed atop an operating system and kernel.

Another feature of the buffered fuel cell is its ability to electrically protect its buffer array from the outside environment, specifically from electrical load 5015

including conducting excessive load currents, from shorted loads, from reverse conduction, or from over-discharging the buffer. Referring again to FIG. 429B, since charge transfer regulator 5013 is interposed between energy storage buffer 5014 and fuel cell array 5011d but not electrical load 5015 it has no means to control or limit currents in load 5015. As such, QXR 5013 does not protect energy storage buffer 5014 from external loads. Instead these protection functions are realized in the BLA buffer load access 5017 interposed between energy storage buffer 5014 and load 5015. BLA features may protect against over current and shorted loads, i.e. where load 5015 draws too high a current, and against reverse current, where load 5015 generates or contains a source of electrical power that improperly tries to charge the buffer through the iBFC output port.

Instead, if energy storage buffer is to be charged from an electrical source other than its fuel cell, in one embodiment shown in FIG. 434C a separate dedicated electrical power called an energy recovery circuit 5018 is included to precondition incoming power sources into a form suitable for charging the buffer array. As such, the function of energy recovery 5018 is to enable direct electrical charging of energy storage buffer 5014. The charging function requires intelligence as the total current delivered to energy storage buffer 5014 from external power sources via energy recovery 5018 plus the current delivered from dynamic fuel cell array 5001d must not exceed the acceptable charging rate, i.e. the acceptable C-rate, for energy storage buffer 5014.

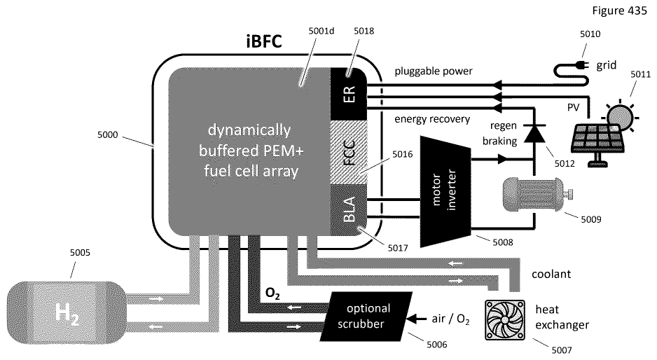

Moreover, energy recovery 5018 module conditions various forms of incoming power to make them compatible with the noise free DC power requirements to properly charge the buffer cells. As shown in iBFC block diagram of FIG. 435, external electrical power sources may comprise pluggable power from grid 5010, photovoltaic power from PV 5011, or energy recovery 5012 such as transient current from regenerative breaking of motor 5009 whenever motor inverter 5008 slows a motor or vehicle thereby converting the drive-train motor into a generator. Aside from the electrical connections to iBFC 5000 as shown, the system also includes hydrogen fuel source 5005, cathode air supply with optional scrubber to remove poison gasses and contaminants 5006, and a cooling system including fan or heat exchanger 5007.

Various embodiment of an intelligent buffered fuel cell made in accordance with this invention, the iBFC offers functionality and performance advantage neither a conventional fuel cell can. Referring to the following comparative table, a conventional fuel cell can generate electricity offering unlimited driving range without the need for charging, has a low weight and has no thermal runaway self heating safety risks while the Li-ion battery is precisely opposite. Conversely a lithium battery is able to store electric charge when a fuel cell cannot, is able to be refreshed from a charger station without the need for fuel, is able to recover waste electrical energy from the environment like from regenerative braking while a fuel cell cannot.

Even more significantly a Li-ion battery pack is capable of delivery high on-demand power at high currents, albeit for limited durations, and represents a low-impedance “stiff” voltage source with milliohm series resistances. By contract the fuel cell cannot deliver high currents without experiencing significant voltage drops, i.e. droop, sag, and dropouts. Lithium ion battery packs can and often do exhibit overheating representing a fire hazard and safety risk.

In contrast, the iBFC offers the best features of both the lithium ion battery and a fuel cell able to deliver high currents into a low impedance load such as motor or a high current DC/DC converter or DC/AC inverter without issue. Moreover, as an omnipower device the iBFC can convert fuel into electricity and store the generated charge or accept electrical power from external electrical power sources including renewable sources such as PV solar or wind; store power from the grid; and capture regenerative energy from motor braking.

| | Li-ion | Fuel | |
|---|---|---|---|
| Feature | Battery | Cell | iBFC |
| Generates electricity | − | + | + |
| Stores electric charge | + | − | + |
| Requires charging | − | + | + |
| Fuel resupply increases kWh | − | + | + |
| Pluggable, charge station refresh | + | − | + |
| Energy recovery (regen braking) | + | − | + |
| Unlimited driving range (refueling) | − | + | + |
| High current | + | − | + |
| Stiff voltage source during transients | + | − | + |
| Able to drive high-I DC/DC converter | + | − | + |
| Able to drive high-P DC/AC inverter | + | − | + |
| Low resistance, low impedance | + | − | + |
| Lightweight | − | + | + |
| No thermal runaway | − | + | + |
| Omnipower input capable | − | − | + |

Because the buffer in the iBFC uses a small fraction of the cells in a battery powered EV or power wall, the iBFC weighs a small fraction of Li-ion batter packs of comparable energy capacities, and greatly reduces the risk of thermal runaway and battery pack fires. One key feature of this invention is the buffered fuel cell's ability to utilize power from multiple inputs—either from fuel such as hydrogen or methanol, electrical energy from the power grid or a backup generator, renewable energy from solar photovoltaic panels or from wind, and energy recovery from regenerative braking, i.e. using a slowing motor to function as a generator recovering its inertial kinetic energy back into electricity.

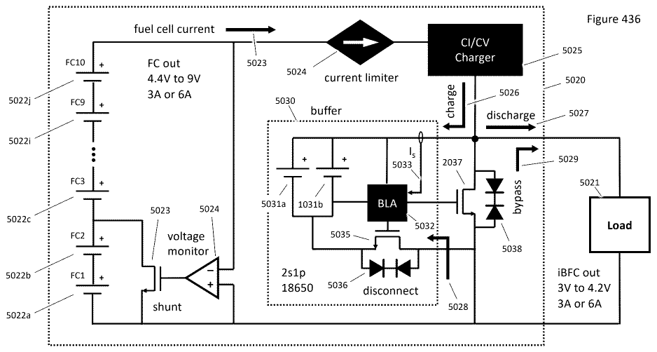

One exemplary schematic of an intelligent buffered fuel cell is shown in FIG. 436. As shown, the iBFC 5020 contains a dynamic array of up to ten fuel cells FC1 to FC10 identified as 5022a through 5022j respectively with a simple FCC fuel cell control comprising voltage monitor and shunt MOSFET in parallel with fuel cells 5022a and 5022b. As such, the dynamic fuel cell as represented can comprise either a 8-cell or a 10-cell array depending in the voltage monitor. The fuel cell current 5023 is then output to CI/CV dual-mode linear or switching charger 5025 through current limiter 5024. Whether the fuel-cell current limiter function is needed depends on the area mA_{FC} of the fuel cell and the buffer and load capacity it is designed to drive.

Buffer 5030 contained within iBFC 1025 comprises electrochemical cells 5031a and 5031b, buffer load access BLA controller 5032, and disconnect switch 5035 including bidirectionally blocking diodes 5036. BLA controller 5032 has two electrical inputs—a voltage input measuring the potential of electrochemical cells 5031a and 5031b, and a current monitor depicted symbolically by a current sensor signal 5033.

In operation, electrochemical cells 5031a and 5031b within buffer 5030 are discharged by load 5021 through a loop comprising currents 5027 and 5028. Concurrently fuel cell current 5023 provides charging current 5026 via CI/CV charger 5025 to replenish charge lost during operation. Any voltage or current outside the cell's safe operating area either exceeding the maximum safe current Iₘₐₓ, exceeding the maximum cell voltage V_{OC}, or discharging below the minimum allowable cell voltage V_{ODC} results in the automatic disconnection of the cell. In stacked module applications whenever a cell is disconnected from load 5021, bypass MOSFET 5037 is activated to provide a shunt current path 5029 allowing the stacked modules to continue operation despite disconnecting buffer 5030 from the external circuit.

Like disconnect MOSFET 5035, bypass MOSFET 5037 in its off state is bidirectionally blocking 5038 represented symbolically by back-to-back diodes. The need for bidirectional blocking in the off state is to prevent both normal polarity conduction and to prevent anomalous reverse current conduction, i.e. prohibit electrical load 5021 from acting as a charger to electrochemical cells 5031a and 5031b in buffer 5030.

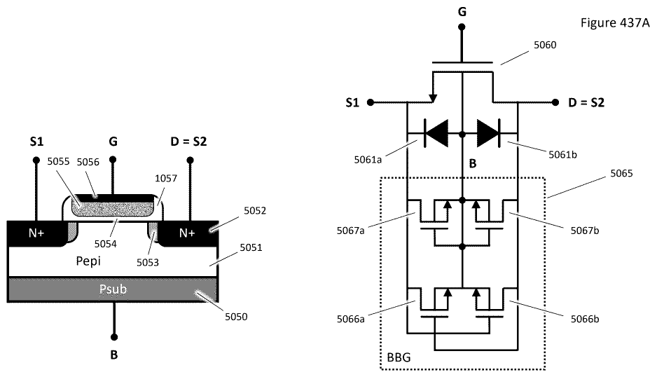

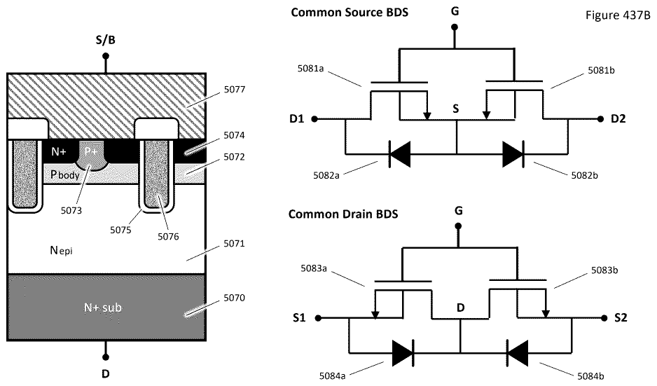

One realization of a bidirectionally blocking MOSFET 5060 is shown in FIG. 437A, using a four-terminal lateral 5V sidewall spacer MOSFET along with circuitry called body bias generator BBG 5065. The MOSFET comprises source and drain N+ regions 5052 formed in P-type epitaxy 5051 grown atop a P-type substrate 5050. To prevent hot carrier damage and increase device breakdown, N-doped lightly doped drain or LDD regions 5053 are fabricated using a self-aligned process, specifically being self-aligned to gate electrode 5056. In the device shown the length of the LDD is not dependent on mask alignment but is instead determined by sidewall spacer 5057 which blocks ion implantation of arsenic used to form N+ regions 5052. To improve switching performance gate 5055 is coated with silicide 5056 formed atop gate dielectric 5054.

The function of body bias generator BGG 5065 is to dynamically bias the body potential on terminal B of MOSFET 5060 to prevent diode conduction of source-to-body diode 5061a and drain-to-body diode 5061b. Note that the nomenclature “drain” is arbitrary in a bidirectional switch as the polarities may reverse based on operating conditions. As such, the terminals are more appropriately referred to S1 and S2. BBG 5065 includes two cross-coupled BBG MOSFETs 5066a and 5066b connecting S1 and S2 to the B body terminal. The gate of BBG MOSFET 5066b is tied to source S1 while the gate of BBG MOSFET 5066a is tied to source S2.

In operation, when the potential of source S1 is more positive than that of S2, i.e. V_{S1}>V_{S2}, then N-channel BBG MOSFET 5066b is biased into an on-state while BBG MOSFET 5066a remains off thereby shorting the body B of power MOSFET 5060 to S2 shorting out intrinsic diode 5061b and reverse biasing diode 5061a. Conversely, when the potential of source S2 is more positive than that of S1, i.e. V_{S2}>V_{S1}, then N-channel BBG MOSFET 5066a is biased into an on-state while BBG MOSFET 5066b remains off thereby shorting the body B of power MOSFET 5060 to S1 shorting out intrinsic diode 1061a and reverse biasing diode 5061b. In the manner only which ever body diode 5061a and 5062 are reversed bias remain in the circuit.

Auxiliary MOSFETs 5067a and 5067b having their gate, source, and body terminals hardwired to the B terminal of power MOSFET 5060 do not switch but function as lower forward dop diodes referred to herein a pseudo-Schottky diodes to prevent the body potential from floating at low bias potentials. Specifically whenever source S1 is more positive than that of S2, i.e. V_{S1}>V_{S2}, but at a voltage below the threshold N-channel BBG MOSFET 5066b, the transistor remains off and the potential at the B terminal floats to an intermediate value when V_{B}>V_{S2}. By forward biasing the body voltage, the source-to-body barrier potential is reduced thereby lowering the threshold connected MOSFET and reducing its turn on voltage limiting the range in which the body voltage can float and preventing leakage current. In other words auxiliary MOSFETs 5067a and 5067b function analogous to Schottky diodes conducting at a lower voltage than enhancement mode MOSFETs 5066a and 5066b.

In an alternative implementation shown in FIG. 437B, two trench power DMOSFETs are connected back-to-back either in a common-drain or in a common-source BDS bidirectional switch configuration. The trench power DMOSFET is a low resistance vertical device comprising a topside shorted source-body metal 5077 comprising a S/B terminal and a backside drain D terminal (metal not shown). The DMOSFET device is formed in a N-type epitaxial layer 5071 grown atop an N+ heavily doped substrate 5070. A moderately doped p-type body P_{body} 5072 forms the channel of the device which contains N+ source 5074. Contact to P_{body} region 5072 is made via a P+ deep body region 5073 forming a butting contact with N+ source regions 5074 in contact with metal 5077. P+ deep body region 5073 is deeper than N+ source regions 5074 but may or may not be deeper than P_{body} region 5072.

The gate electrodes 5076 are embedded in a vertically etched trench lined with a gate oxide 5075. The gate oxide may or may not be uniform along the trench at the bottom of the trench or along its sidewall between the trench bottom and the P_{body}-to-Nₑₚᵢ junction. The device is referred to a DMOSFET because of its double diffused structure, i.e. first diffusing the body P_{body} 5072 into the epitaxial Nₑₚᵢ layer 5071, then implanting and diffusing the source N+ 5074 within P_{body} 5072. Because of concentration gradient between body P_{body} 5072 and epitaxial Nₑₚᵢ layer 5071, most depletion spreading in the off-state extends into the lightly doped Nₑₚᵢ layer 5071 and not into the more highly doped body region P_{body} 5072. In this manner the device can achieve submicron channel lengths with no short channel effects. Breakdown voltages can range from 15V to hundreds-of-volts with most devices rated at 30V and 60V. Bothe P-channel and N-channel devices are available.

Using two identical trench DMOSFET devices, a bidirectionally blocking bidirectionally conducting switch with low on-state resistance and superior blocking characteristics can be realized. In one configuration two trench DMOSFET devices 5081a and 5081b are connected in a common source arrangement where the body-to-drain antiparallel diodes 5082a and 5082b are biased in opposing directions to prevent diode conduction between drain terminals D1 and D2. As such, BDS conduction occurs only via the MOS channel under gate control regardless of the connection polarity.

In another configuration two trench DMOSFET devices 5083a and 5083b are connected in a common drain arrangement. Similarly, in the common drain connection the body-to-drain antiparallel diodes 5084a and 5084b face opposing directions thereby preventing diode conduction between drain terminals D1 and D2.

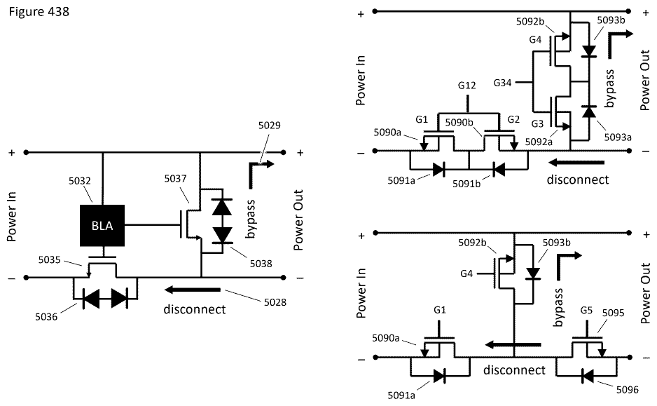

In realizing the BLA 1032 buffer load access functions of bidirectional disconnect 5028 and bypass 5029, both MOSFETs 5035 and 5037 shown in FIG. 438 must block bidirectionally 5036 and 5038 in their off state. Implementing the two BDS switches using discrete power devices requires four DMOSFETs—DMOSFETs 5090a and 5090b with integral anti-parallel diodes 5036 and 5038 to form the disconnect switch pair and DMOSFETs 5092a and 5092b with integral anti-parallel diodes 5093a and 5093b to form the bypass switch.

Because negative terminal is shared, one of the devices can be eliminated simply altering the logic gate truth table. In this compact circuit DMOSFETs 5090b and 5092a are eliminated and replace by DMOSFET 5095. Because the intrinsic antiparallel diode 5096 in DMOSFET 5095 is diametrically opposed to diodes 5091a in the disconnect switch and 5092b in the bypass switch, bidirectional blocking is not compromised. By combining the disconnect and bypass functions two of the four discrete DMOSFETs can be eliminated to realize the BLA function resulting in reduced power loss within the power DMOSFET semiconductor switches.

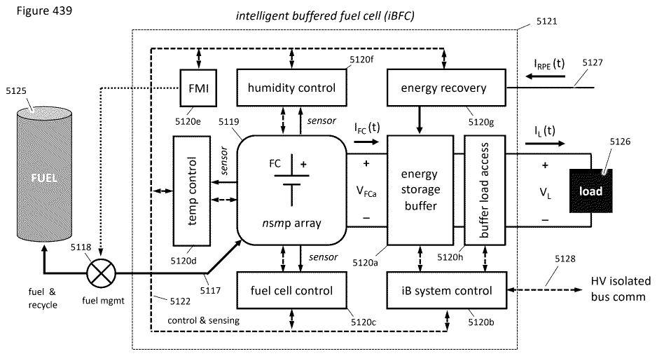

The described functions are part of the buffered load access module 5120h in the iBFC intelligent buffered fuel cell 5121 shown in FIG. 439. In addition other iBFC functions made in accordance with this invention and described further in a related patent application “Intelligent Buffered Fuel Cell with Low Impedance” included by reference herein include the following:
Series-parallel fuel cell array 5119 capable of dynamic reconfiguration of array electrical topology including number of series connected cells and the fuel cell area along with internal electrical, thermal, and humidity sensors.
Fuel cell control module 5120c controlling fuel cell array topology in dynamically reconfigurable fuel cell arrays and gas microvalves.
Intelligent energy storage buffer 5120a with integrated regulating charger facilitating energy storage, impedance matching, overvoltage and overcurrent protection, and buffer charge balancing functions. Energy storage buffer 5120a stores electric charge and is therefore sometimes referred to through this invention as electrical storage. Unlike most components in the iBFC which comprise unidirectional flow, electrical currents within energy storage buffer 5120a are bidirectional, able to source and absorb energy.
Energy recovery ER module 5120g able to convert power sources such as generators, power supplies, uninterrupted power supplies, pluggable power, renewable power, regenerative power, or energy harvesting into DC power suitable for charging energy storage buffer 5120a and to protect the energy storage buffer from damage. The ER module may also contain a rectifier-filter for converting AC coupled power into floating DC using galvanic isolation. Electrical energy flow into ER module 5127 is denoted by the current I_{RPE} the subscript being an acronym for recovered and pluggable energy recognizing renewable and harvested energy is separate and distinct from “pluggable” grid power sources.
Buffer load access (BLA) module 5120h protecting energy storage buffer 5120h from adverse conditions cause by external connection to load 5126 including protecting against overcurrent from a shorted load, limiting over-discharge of buffer cells, and preventing reverse current from electrical loads containing their own internal power sources. As such, iBFC current flow in the BLA is unidirectional flowing outward from the iBFC to load 5126. Buffer load access also facilitates the dynamical ability to disconnect or shunt fuel cells from a series stack without interrupting current of disrupting iBFC operation and to conserve fuel consumption in disabled cells.
Intelligent buffer system controller 5120b with high-voltage isolated external interface bus 5128 and internal iBFC communication bus 5122 facilitating inter-module communication within the iBFC system.
Temperature control module 5120d to up-regulate (heat) or down-regulate (cool) temperature of fuel cell array 5119 thereby enabling cold start capability and providing protection from fuel cell overheating.
Humidity control module 5120f able to humidify fuel such as hydrogen gas delivered from fuel supply container 5125 to fuel cell array 5119 or to directly humidify the anode or cathode of fuel cells comprising fuel cell array 5119.
Fuel management interface FMI 5120e able to control external fuel management module 5118 to control the flow rate and pressure of fuel supply and recycle lines 5117.

Collectively, the various functional modules or blocks comprising energy storage buffer 5120a, intelligent buffer system controller 5120b, fuel cell control module 5120c, temperature control module 5120d, fuel management interface FMI 5120e, humidity control module 5120f, and energy recovery module 5120g comprise intelligent buffer (iB) 5120. As such, the intelligent buffered fuel cell iBFC 5121 can be represented in a simplified form comprising a dynamic fuel cell array 5119, intelligent buffer (iB) 5120, and communication comprising control bus 5122.

### Power Dissipation.

Although the concept of the intelligent buffered fuel cell is adaptable to wide range of electrical applications, it is more efficient to deliver power at higher voltages than at lower potentials. The principle that power delivery is more efficient at higher voltages is universally applicable to all electrical energy sources including the power grid, batteries in BEV battery electric vehicles, and even for the buffered fuel cell as disclosed herein.

The value of operating at higher voltages can be best understood by using simple electrical network analysis. By representing a real power source using a lumped element model as an ideal voltage source having voltage Vₛ in series with a lumped element resistor having resistance Rₛ power transfer and power losses can be analyzed. Assuming a lossless power source, i.e. where η=100%, power generated by the idealized voltage source is given by the network branch constraint Pₛ=ηIₛVₛ=IₛVₛ. Similarly power P_{L} delivered to the electric load is given by P_{L}=I_{L}V_{L}. Power loss in the resistor is likewise given by P_{R}=I_{R}V_{R}.

If we consider a single-loop circuit containing the three identified components, namely a power source, load, and resistor, then in accordance with KVL Kirchhoff's voltage law the loop voltage must sum to zero, i.e. V_{L}+V_{R}−V_{S}=0. By convention the source voltage Vs has minus sign to denote it is a power source rather than an electrical load. Rearranging the equation for the output voltage gives the result V_{L}=V_{S}−V_{R}. With lonely one loop, the current in every element in identical meaning I=I_{L}=I_{S}=I_{R}. Given the general equal P=IV, the KVL voltage equation can be rewritten in terms of power as IV_{L}=(IV_{S}−IV_{R}) or simply P_{L}=P_{S}−P_{R} where power is lost in the resistance in transit to the load. Although many sources of resistance may arise in a power electrical circuit, in most cases the power losses occur in power semiconductor device such as the aforementioned power MOSFETs used in power supplies, disconnect switches, and in power multiplexers.

Aside from causing unwanted energy losses and lower energy efficiency, power dissipation in the power devices causes unwanted heating. The power MOSFET must survive the elevated temperature from its own self heating or in may burn up. Unfortunately, in the vast majority of power applications, there is never a good source of heat sinking to remove waste heat, especially in surface mounted power MOSFETs which can only remove heat convectively via copper cladding of the PCB printed circuit board, typically deposited to thickness of 70 μm corresponding a copper weight of 610 g/m², commonly referred to as a 2-ounce copper PCB.

In low-frequency power switching applications, the power MOSFET is modelled as a constant resistance carrying an average current I=lₐᵥₑ=IₚₑₐₖD where D is the duty cycle representing the conduction on-time divided by the total clock period. To determine the temperature rise, parameters include the dissipated power in watts; the resistance in ohms; the maximum allowable junction temperature Tⱼ(max) in ° C.; the ambient temperature Tₐ in ° C., and the ability of the PCB copper to dissipate heat measured by the thermal resistance θ in ° C./W.

Since power loss in the series resistance P_{R} is given by the relation P_{R}=IV_{R} by using Ohm's law V_{R}=IR we can modify the power loss equation into P_{R}=I(IR)=I²R. This relation reveals the important consideration that power loss depend on the square of the current, meaning delivering power from a source to an electrical load at a high current dissipates more power losses and creates more heat than using a lower current and a higher voltage. This factor is the reason the power grid uses a high voltage transmission network, and only drops the voltage locally for residential power.

As described previously since the power delivered by a power source is given by the relation Pₛ=ηIₛVₛ=IVₛ where η=100%, then I=Pₛ/Vₛ. Substituting this current into the resistive power loss equation results in the power transfer function describing power loss P_{R} as a function of source power input power Pₛ and series resistance Rs, as given by

$${P}_{R} = {I}^{2} {R}_{S} = {( \frac{{P}_{s}}{{V}_{s}} )}^{2} {R}_{s}$$

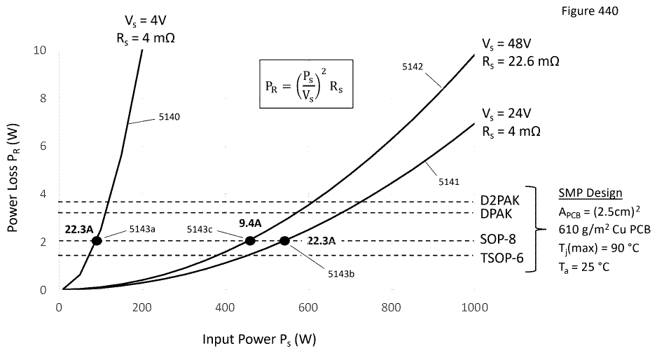

This relation is plotted in FIG. 440 showing the power dissipation as a function of power input for three different output voltages. As shown, curve 5140 describes the losses in a 4 mΩ power MOSFET delivering power from a 4V source. At 22.3 A shown by point 5143a the power device dissipates 2 W of heat while the source delivers an input power of Pₛ=IVₛ=(22.3 A)(4V)=89.2 W. By contrast curve 5141 describes the losses in a 4 mΩ power MOSFET delivering power from a 24V source. At 22.3 A shown by point 5143b the power device dissipates 2 W of heat while the source delivers an input power of Pₛ=IVₛ=(22.3 A)(24V)=535.2 W, roughly half a kilowatt. Comparing the 24V and 4V solutions, the higher voltage system delivers 533 W of power to the load over six times the power of a 4V solution supplying only 87 W. To deliver the same power as a 24V power source, the current in a 4V supply must significantly higher with commensurately higher power losses.

Extending the concept to a 48V supply produces a counterintuitive result. As shown by curve 5143c, a 48V source delivers less power to a load than the 24V supply of curve 5141. As shown by point 5143c, thermal losses of 2 W occurs at 9.4 A. Ideally doubling the voltage should halve the current, maintain the same input power, and improve output power by lower conduction losses I the power MOSFET resistance. Unfortunately the 4-mΩ 30V trench DMOSFET used in a 24V system is not applicable for use in 48V systems. Instead a 60V device must be used.

The higher blocking voltage requires use of a thicker-more resistive epitaxial layer. In voltage scaling of power MOSFETs the resistance increase by the breakdown voltage ratio raised to the power of 2.5V. Algebraically voltage scaling can be expressed as [R_{DS}A]₂=(V_{B2}/V_{B1})^{2.5}[R_{DS1} A]₁≈5.3 [R_{DS1} A]₁. So even though the current is halved and the power loss reduced by ¼^{th}, the resistance increased by 5.3× resulting in a net loss in performance.

So limiting the thermal dissipation in a PCB mounted power MOSFET lacking heat sinking is a key design consideration in designing the maximum conducted current in a system. The maximum power dissipation is given by the temperature rise ΔT=Tⱼ(max)−Ta and the convective thermal resistance θ according to the equation

$$P \leq \frac{{T}_{j} ( max ) - {T}_{a}}{θ} = \frac{Δ T}{θ}$$

The specific value of thermal resistance depends on the PCB and the semiconductor package design. A sample of various surface mount packages used by power MOSFET is described in the table below. The power levels shown in the table are illustrated on the graph for a A_{PCB}=(2.5 cm)² with 610 g/m² copper cladding.

As explained in the prior paragraph, 24V is an especially beneficial voltage for delivering significant power levels. Applications include residential, commercial, transportation, and mobility energy. By delivering power at 24V, currents are reduced six-fold from that of 4V lithium ion battery based systems when delivering the same rated power at a higher voltage. Moreover, at 24V a 4 mΩ power MOSFET can conduct up to 23 A without exceeding the 2 W package power limit, thereby delivering up to 530 W to a load.

| Package | θ | Tⱼ(max) | Ta | ΔT | P(max) (W) |
|---|---|---|---|---|---|
| D2PAK | 18.0° C./W | 90° C. | 25° C. | 65° C. | 3.6 W |
| DPAK | 22.2° C./W | | | | 2.9 W |
| SOT-223 | 27.2° C./W | | | | 2.4 W |
| SOP-8 | 33.0° C./W | | | | 2.0 W |
| TSOP-6 | 47.3° C./W | | | | 1.4 W |
| TSSOP-8 | 60.9° C./W | | | | 1.1 W |

https://electronics.stackexchange.com/questions/103166/how-does-power-dissipation-for-surface-mount-components-work

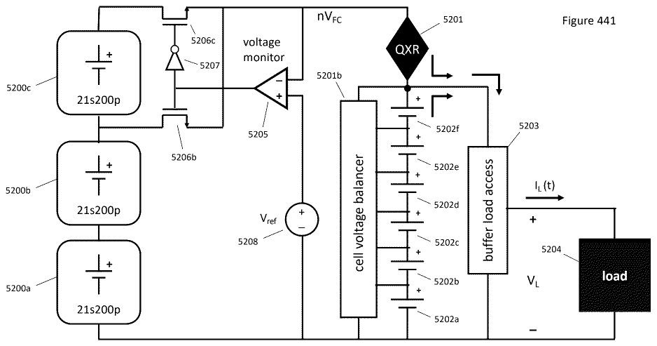

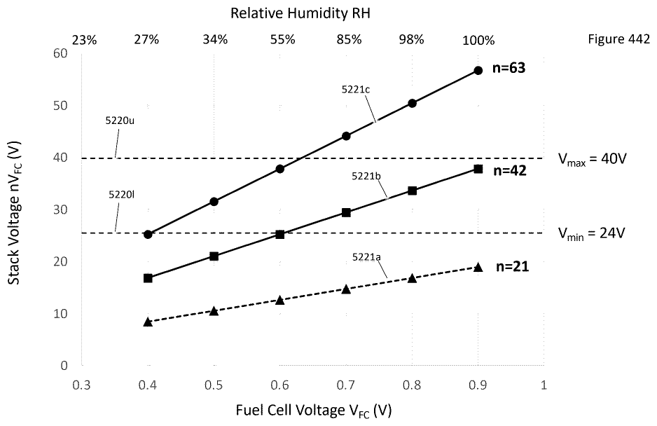

An exemplary circuit, FIG. 441 illustrates a stack of three series connected fuel-cell modules 5200a, 5200b, and 5200c, each comprising a fixed topology of 21s200p. Electrical characteristics of the n=21 module ranges in voltage from 8.4V≤nV_{FC}≤19V shown by curve 5221a in FIG. 442 corresponding to single fuel cells voltages of 0.4V≤V_{FC}≤0.9V. At a current density of mA/cm² the fuel cell stack is able to deliver up to 42 A. The modules are dynamically reconfigurable using a power multiplexer comprising MOSFETs 5206b and 5206c drive out of phase by inverter 5207 and voltage monitor 5205 compared to V_{ref} reference voltage 5208.

Fuel cell stacks 5200a and 5200b are hardwired in series to produce a fixed cell configuration comprising n=42 as shown by curve 5221b. In operation whenever voltage monitor 5205 detects the fuel stack voltage nV_{FC} falls below V_{ref} reference voltage 5208, pass transistor 5206b is turned off and pass transistor 5206c is turned on increasing the fuel cell stack by 21 cells so that n=63. By increasing the stack to n=63, the voltage transfer function transitions from n=42 curve 5221b to n=63 curve 5221c.

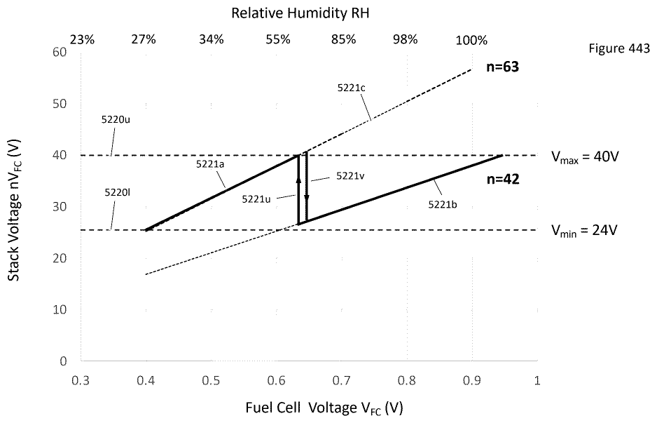

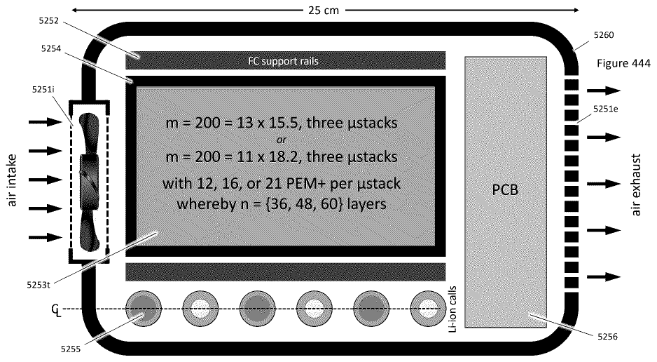

As shown in FIG. 443, by dynamically reconfiguring the array and switching the value of reference voltage, the output voltage nV_{FC} of the dynamic fuel cell stack can be maintained in a predefine range, in this example between Vₘₐₓ≈40V shown by line 5220u and Vₘᵢₙ≈25V shown by line 5220l. As such, the unregulated output voltage of the buffered fuel cell is constrained between 25V≤nV_{FC}≤40V. Reference voltage 5208 includes hysteresis where negative transition 5221v from curve 5221c to curve 5221b differs from positive transition 5221u from curve 5221b to curve 5221c. Referring again to the schematic in FIG. 436, QXR charge transfer regulator 5201 charges a string of six lithium ion cells 5202a to 5202f balancing the voltage evenly among them via balancer 5201b.

The series battery array is connected to load 5204 through a protection circuit referred to as BLA buffer load access 5203. Each cell is contained in battery holder 5258 with contacts applying pressure to eliminate contact resistance without the need to solder wires to the battery terminals which risks battery damage. In the embodiment of FIG. 441, three μstacks are multiplexed to maintain a quasi-constant fuel cell output voltage shown by curves 5221a and 522b in FIG. 443. QXR 4201 supplies the fuel cell stack to a comparable voltage series connected battery array 5202a through 5202f.

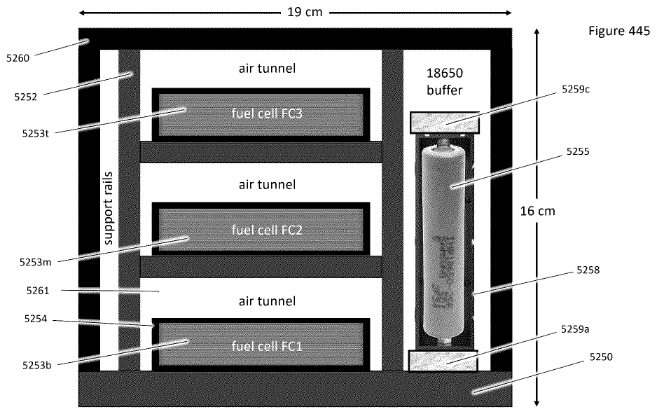

An exemplary schematic representation of a 24V iBFC module is shown in the top view of FIG. 444 and in endwise view FIG. 445 includes top, middle, and bottom 21s120p μstack fuel cells 5253t, 5253m, and 5253b surrounded on two sides by support rails 5252 which may include electrical and gas conduits, together mounted on a base plate 5250. The base plate connects electrical connections and gas ports to an under chassis (not shown). It also includes a series of series connected 18650 Li-ion cells 5255 connected by conductive straps 5259a and 5259c.

The entire module is enclosed in encasement 5260 forming wind tunnels 5261 to convectively cool fuel cell μstacks 5253t, 5253m, and 5253b. In the example shown, each of the three μstacks comprise an rectangular geometry m_{FC}=200 arranged in an aspect ratio oof 15.5×13. The active area of the each μstack in the fuel cell is m_{FC}(A_{FC})=200(1 cm²)=200 cm². The number of layers per μstack as shown varies. In one case the fuel cell comprises three 12-layer μstacks with n=36 total PEM+ membranes. In a second case, the fuel cell comprises three 16-layer μstacks for n=48 total PEM+ membranes. In a third case, the fuel cell comprises three 21-layer μstacks for n=63 total PEM+ membranes.

The forced-air powered by fan 5251i, transiting the length of the module, and exiting through grating 5251 located at opposite ends of 24V iBFC module enclosure 5260, delivers convective surface cooling along the exposed surfaces of the three fuel cell μstacks 5253t, 5253m, and 5253b. The forced-air convective surface cooling of the μstacks occurs in addition to internal fuel cell cooling provided by cathode air flow for oxygen delivery or by any dedicated fluid cooling channel carried in tripolar plates internal to each fuel cell stack. Additional cooling may also be achieved by thermal conduction from the bottom surface of each fuel cell μstacks in thermal contact with the metallic frame forming support shelves within the module. The metal plate may be actively cooled or temperature regulated.

In one embodiment the combination of thermal conduction into its backplate, convection across its surface, and forced airflow through its cathode provide three cooperative forms of heat removal from the active fuel cells. By limiting the height of the μstacks, the temperature gradient across the stack is limited and heat conduction into the backplane is maximized. In another embodiment the backplane to which the μstacks are attached includes embedded cooling such as liquid heat or refrigerant transfer.

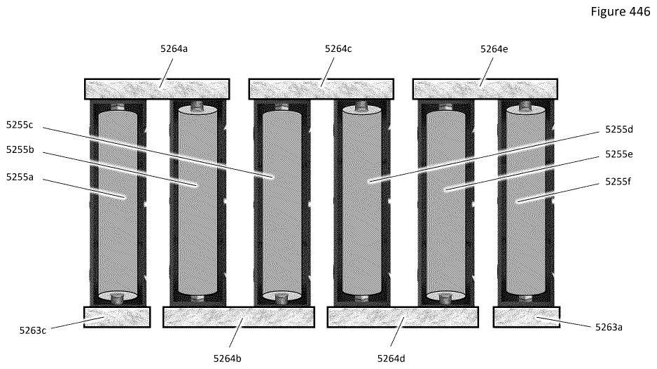

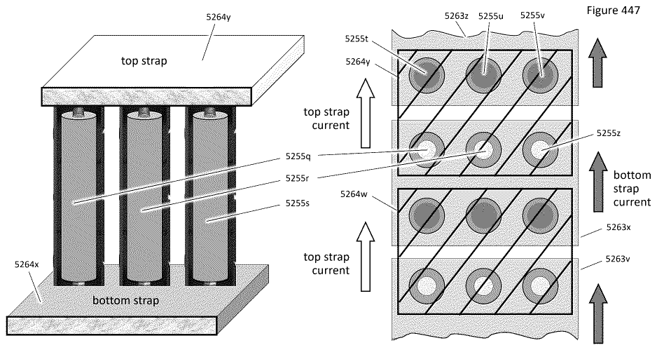

In another embodiment, one-or-more series arrays of electrochemical buffer cells such as lithium ion batteries are connected in series, positioned perpendicular to the baseplate or printed circuit board. The electrochemical buffer cells comprising Li-ion, Na-ion, or other chemistries located along cutline CL identified in FIG. 444 are shown in side view in FIG. 446 comprising buffer cells 5255a through 5255f. Electrical contacts include cathode and anode terminals 5263c and 5263a along with conductive straps 5264a through 5264e. As indicated the Li-ion cells are connected alternating in antiparallel orientations, i.e. cathode up, anode up, cathode up, etc. where the conductive straps create a series connected stack. In the example shown, the cells comprise a single series string forming a 6s1p cell array.

The buffer array can be expanded to form a battery buffer comprising two series parallel strings 6s2p, three parallel strings 6s3p, four parallel strings 6s4p or more. With a nominal voltage of 3.88V per cell during discharge an a 1 C discharge rate of I_{1C}=3.2 A, each 6s1p string contains P_{bat}=σ6(I_{bat})(V_{bat})=6(3.2 A)(3.8V)=6(12 W)=72 W per buffer string containing E=72 Wh of energy.

In the case of parallel connected cells, it is beneficial to metallically strap the cathodes and anodes of parallel cells to ensure they maintain the same voltages. Referring to FIG. 447, an 24V array of buffer cells form a series-parallel buffer having a topology 6s3p comprising a series string of six 3p connected cells, only four of which are shown. Accordingly a 6s3p array contains E_{buf}=3(72 Wh)=216 Wh=0.22 kWh for every 6s3p array.

As shown, the array includes bottom metallic straps 5263v, 5263x, top metallic straps 5264w and 5264y connecting an array of electrochemical cells in alternating antiparallel orientations. For example, parallel cells 5525q, 5525r, and 5525s are oriented with anode-up cathode-down while parallel cells 5255t, 5255u, and 5255v are positioned cathode-up anode-down.

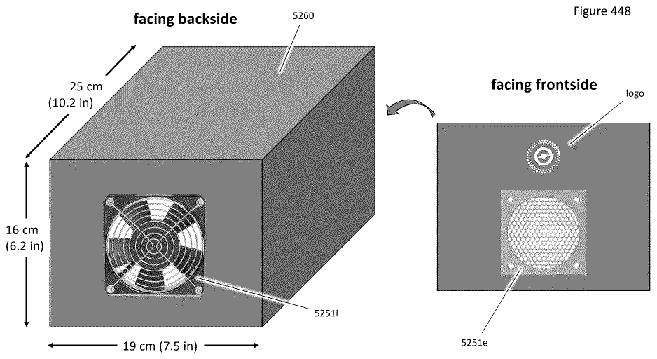

FIG. 448 illustrates the exterior view of encasement 5260 showing air intake fan 5251i and air exhaust grill 5251e. Exemplary dimensions of the 24V module comprise 19 cm (7.5 in) wide×16 cm (6.2 in) tall by 25 cm (10.2 in) deep comprising a total of 7,600 cm³. At 1000 W, the module has a power density of 130 mW/cm³ with each of the three μstacks generating 333 W of usable electric power.

Operating at 80% efficiency, each μstack consumes 416 W releasing 83 W of heat. By actively maintaining a back plate at 25° C. and limiting the maximum fuel cell temperature to 90° C. means the maximum temperature differential ΔT between the peak allowable PEM+ membrane temperature T_{μs} and the backplate T_{bp} is ΔT=(T_{μs}−T_{bp})=(90° C.−25° C.)=65° C. The thermal impedance θ_{cond} required for maintaining this temperature differential exclusively by conductive cooling while dissipating P_{μs}=83 W is then equal to θ_{cond}≤ΔT/P_{μs}=68° C./83 W=0.8° C./W not accounting for any convective surface cooling, cathode air flow convection, or refrigerant cooling. The specifications of an iBFC module therefore may comprise two ratings—one for liquid cooling, the other for air cooling, both for which include thermal conduction into a cooled backplate. Generally. using liquid cooling the ratings are determined by electrical limitations while air cooled operation is primarily determined by thermal considerations. Electrical specifications are calculated as follows
Voltage—Fully charged iBFC voltage maintains a 24V constant voltage so long that the discharge rate. i.e. load current, is less than the fuel cell 42 A output capability. Although a lithium ion cell is operate down to 0.7V some capacity loss occurs deeply discharging a battery. As such, the minimum rated output voltage Vₘᵢₙ of the disclosed module is 22.8V, i.e. V_{buf}≥3.8V with the majority of stored electrical energy at or above 23.3V.
Continuous Output Current—As specified in the following table, the continuous current output of the a 36s200p fuel cell is 43 amps with real-time refreshing of the buffer. In continuous conduction, the buffer array is in equilibrium with no net energy flow or change in its state-of-charge. As such, the continuous current of the buffered fuel cell is 43 A running at a current density of [I_{FC}/A_{FC}]=215 mA/cm². In an alternative embodiment the fuel cell can be run at a higher current density by monitoring the internal temperature of the fuel cell and increasing the current appropriately.
PoD Output Current—Power-on-demand comprises the sum of continuous fuel cell current plus the current supplied when a battery is being discharged at a 1 C-to-2 C rate per buffer string without recharging. At 1 C the buffer can support the current for 1 hour, while at 2 C the buffer can only maintain a discharge current for 30 minutes. The PoD heavy load iBFC current is thereby is specified by the range (I_{FC}+m_{buf}(I_{1C}))≤I_{PoD}≤(I_{FC}+m_{buf}(I_{2C})). Given a fixed continuous fuel cell current of I_{FC}=43 and a nominal Li-ion discharge rate of I_{1C}=3.2 A, the PoD current range for m_{buf}=1 is 46 A-to-49 A for a 6s1p buffer. The PoD current range for m_{buf}=3 is 53 A-to-62 A for a 6s3p buffer. The PoD current range for m_{buf}=⁶ is 62 A-to-81 A for a 6s6p buffer.
Transient Output Current—The 10 s-transient power current comprises two elements (i) running the fuel cell at a higher current density, e.g. at [I_{FC}(10 s)/A_{FC}]=420 mA/cm²; and (ii) conducting a discharge current in each string of buffer cells at 10 C, ten times the nominal discharge rate for a electrochemical cell like Li-ion, i.e. where I_{10C}=32 A per string. As such, the ten-second transient current is I₁₀ₛ=[I_{FC}(10 s)/A_{FC}](A_{FC})+m_{buf}(I_{10C})=[420 mA/cm²](200 cm²)+m_{buf}(30 A)=84 A+m_{buf}(I_{10c}). For m_{buf}=1, I₁₀ₛ=84 A+32 A=116 A; or m_{buf}=3, I₁₀ₛ=84 A+96λ=180 A; and for m_{buf}=6, I₁₀ₛ=84 A+182 A=276 A.
Continuous Output Power—The iBFC continuous output power is given by Pₒᵤₜ=(Iₒᵤₜ)(Vₒᵤₜ)=(43 A)(23.3V)=1 kW regardless of the number of series buffer strings m_{buf}. By the same definition, a competitive lithium ion battery pack's continuous output power is zero.
PoD Output Power—The power-on-demand output power for the iBFC is P_{PoD}=(I_{PoD})(Vₒᵤₜ) where for m_{buf}=1 (23.3V)(45 A)=1072 W≤P_{PoD}≤(23.3V)(40 A)=1142 W only slightly higher than the continuous power output. PoD deviates from continuous power as the number of series strings m_{buf} increases. For m_{buf}=3, then (23.3V)(53 A)=1235 W≤P_{PoD}≤(23.3V)(62 A)=1445 W. For m_{buf}=6, then (23.3V)(62 A)=1445 W P_{PoD}≤(23.3V)(81 A)=1888 W.
Transient Output Power—The 10 s-transient output power P₁₀ₛ=(I₁₀ₛ)(Vₒᵤₜ) where for m_{buf}=1 the pulse power is P₁₀ₛ=(116 A)(23.3V)=2703 W. For m_{buf}=3 the pulse power is P₁₀ₛ=(180 A)(23.3V)=4194 W. For m_{buf}=6 the pulse power is P₁₀ₛ=(276 A)(23.3V)=6431 W.

The table to follow summarizes features on three buffered fuel says comprising three 12-layer μstacks of area A_{FC}=200 cm² buffered by electrochemical arrays comprising 6s1p, 6s3p, and 6s6p topologies.

As described, a buffered fuel cell provides power-on-demand (PoD) at any humidity, but loses its ability to fully refresh itself below a specified humidity depending on the design of the dynamic fuel cell array. For example, for a fuel cell array comprising a total of 36-layers the minimum humidity level is around 75% while for 48-layers the minimum RH is 34%. By contrast, a 60-layer system works down to 27% humidity. Operation of this minimum humidity level, the output is able to maintain 24V or greater and charge the buffer stack to a voltage of at least 23.3V, i.e. 3.88V per cell. As such, a s200p iBFC is able to maintain a continuous output voltage of 23.3V.

Unlike conventional fuel cells that push power output to its thermal limit and attempt to control power output by regulating gas flows, the iBFC avoids overheating by maintaining a more efficient operating current maintained electronically by the charge transfer regulator and through its fuel cell control circuit. Fundamentally controlling current output through gas flow control is a bad idea as a significant time delay necessarily occurs between sensing a change in electrical loading and adjusting gas flow to react.

| Specification | Typical Value | | Condition |
|---|---|---|---|
| Output Voltage, | 23.3 | V | 25 V ≤ nV_{FC} ≤ 40 V, |
| Nominal | | | dyn, V_{buf} = 3.88 V |
| Output Voltage, Range | 22.8 V to 25.2 V | | n_{buf} = 6, 3.8 V ≤ |
| | | | V_{buf} ≤ 4.2 V |
| Output Current, | 43 | A | [I_{FC}/A] = 215 mA/cm², |
| Continuous | | | m = 200, I_{buf} = 0 |
| Output Current, | 46 A to 49 A | | 6s1p, 1 C-to-2 C |
| PoD (1 h to 30 m) | | | discharge, I_{1C} = 3.2 A |
| Power-on-Demand | 53 A to 62 A | | 6s3p, 1 C-to-2 C |
| | | | discharge, 3I_{1C} = 9.6 A |
| | 62 A to 81 A | | 6s6p, 1 C-to-2 C |
| | | | discharge, 6I_{1C} = 19.2 A |
| Output Current, | 116 | A | 6s1p, I_{10C} = 32 A, |
| Transient (10 s) | | | I_{FC}/A = 430 mA/cm² |
| | 180 | A | 6s3p, I_{10C} = 32 A, |
| | | | I_{FC}/A = 430 mA/cm² |
| | 276 | A | 6s6p, I_{10C} = 32 A, |
| | | | I_{FC}/A = 430 mA/cm² |
| Output Power, | 1000 | W | buffer equilibrium, |
| Continuous | | | net I_{buf} = 0 |
| Output Power | 1072 W to 1142 W | | 6s1p, 1 C-to-2 C |
| PoD (1 h to 30 m) | | | discharge. I_{1C} = 3.2 A |
| Power-on-Demand | 1235 W to 1445 W | | 6s3p, 1 C-to-2 C |
| | | | discharge, 3I_{1C} = 9.6 A |
| | 1445 W to 1888 W | | 6s6p, 1 C-to-2 C |
| | | | discharge, 6I_{1C} = 19.2 A |
| Output Power, | 2703 | W | 6s1p, I_{10C} = 32 A, |
| Transient (10 s) | | | I_{FC}/A = 430 mA/cm² |
| | 4194 | W | 6s3p, I_{10C} = 32 A, |
| | | | I_{FC}/A = 430 mA/cm² |
| | 6431 | W | 6s6p, I_{10C} = 32 A, |
| | | | I_{FC}/A = 430 mA/cm² |
| Power Output/μstack, | 333 | W | Surface air flow rate |
| 3 μstacks | | | FR > 200 cm/s |
| Conversion Efficiency | 80% | | Cathode flow rate |
| Power Consumption/ | 416 | W | 60 SLPM, 0.08 cm/s |
| μstack | | | Conduction into |
| Power Loss, Heat/μstack | 83 | W | cooled plate |
| Thermal Impedance θ_{μs} | 0.8° | C./W | |
| Maximum μstack | 90° | C. | |
| Temp T_{μs} | | | |
| Backplate Temp T_{bp} | 25° | C. | |
| Input Current, | 3.2 | A | 6s1p, 1 C charge |
| Charging (1 h) | 9.6 | A | 6s3p, 1 C charge |
| | 19.2 | A | 6s6p, 1 C charge |

Firstly, adjusting gas flow rates is inaccurate and nonlinear, relying on temperature sensing or other indirect means difficult to calibrate. Secondly, gas flow control using mass flow controllers is imprecise leading large current fluctuations including overshoots and undershoots. Lastly a significant time lag occurs from when a flow is adjusted until when the gas concentration within the fuel cell anode changes and the reaction kinetics change.

By contrast, so long that a minimum required gas flow is maintained current regulation in the iBFC is entirely electronic. Excess hydrogen flowing into the anode unused in conduction reverts from protons back into gas thereby naturally limiting the proton concentration to precisely match the current demanded by the QXR circuit. The reaction time and current regulation occurs in nanoseconds, orders of magnitude faster than gas regulation. In this way, the iBFC is vastly superior to conventional prior art fuel cells.

### 24V μStack Design.

Thermal design considerations play an important if not critical role in architecting and fabricating a reliable fuel cell. As described previously, one way to reduce internal heating in a fuel cell is to control overdrive, i.e. matching the unregulated output voltage of a fuel cell stack to the buffer it is intended to charge. Rather than employing a voltage regulator to control a fuel cell's output voltage, the inventive method disclosed herein uses a dynamically reconfigurable fuel cell stack to produce a quasi-constant voltage, importantly without regulation. By eliminating the need for a large high-current voltage regulator, an additional source of power dissipation and heat generation is eliminated.

In principle, a dynamic fuel cell changes the number of membranes electrically connected in series within a fuel cell stack to adjust for changing conditions of temperature, humidity, and current and their influence on output voltage. While using switches to include or remove individual membranes from a fuel cell's series circuit may benefit a six-volt array, in a 24V buffered fuel cell each individual membrane represents less than 3% of the output voltage. In a 400V stack, each layer contributes as little as 0.1% to the stack voltage.

So although dynamically reconfiguring individual ionomeric membranes may reduce waste heat, such an solution is costly and unwieldy to implement on a layer-by-layer basis, especially in higher voltage containing dozens or hundreds of connected layers. Moreover producing a spectrum of custom fuel cells of varying layer counts is inefficient and costly manufacturing. Instead it is advantageous to assemble a fixed-height fuel cell μstack reusable in a wide spectrum of fuel cell designs as a standard. In operation, one or more μstacks are dynamically switched in and out of the fuel cell series circuit to adjust the fuel cells output voltage.

Selection of the number of membranes in the μstack represents a compromise between too few layers having insignificant impact in controlling losses and requiring too many μstack assemblies and too many layers concentrating heat and not limiting the voltage range. As shown previously in FIG. 436, one possible implementation comprises three 21-layer μstacks which in operation functions with either 42 or 63 layers thereby limiting the total voltage between 24V to 43V. The disadvantage of this design is each μstack comprises 21 layers generating heat.

One solution to reduce heating is to divide the fuel cell into more μstacks each with fewer layers. For example by reducing the number of layers from 21 membranes down to 12 layers the heat within the μstack is reduced by 43%. Compared to a single 63 layer stack the electrochemically heat generated within a 12-layer fuel cell stack is reduced by 80%.

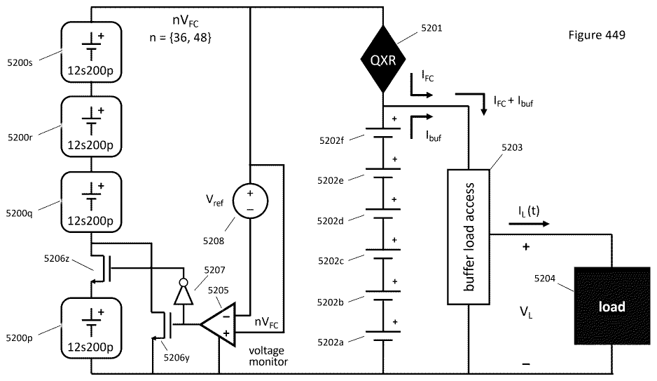

FIG. 449 illustrates one fuel cell implementation comprising four 12-layer μstacks 5200p to 5200s selectable as either a 36-or-48 layer fuel cell stack. Accordingly the dynamic fuel cell design is referred to as a n={36, 48} iBFC. In operation, the number of conducting μstacks depend on the state of voltage monitor 5205. The voltage monitor 5205 comprises a comparator which compares the aggregate fuel cell stack voltage V_{FC} to reference voltage V_{ref}. In the case where V_{FC}<V_{ref}, the comparator output of the voltage monitor 5205 is in its low state, i.e. a digital ‘0’ or 0V, turning off bypass MOSFET 5206y.

Concurrently inverter 5207 turns on pass-through MOSFET 5206z connecting μstack 5200p in series with μstacks 5200q to 5200s resulting in a fuel cell stack 48s120p. In the case where V_{FC}>V_{ref} the comparator output of the voltage monitor 5205 is in its high state, representing a digital ‘1’ such as +5V turning on bypass 5206y and disabling pass-through MOSFET 5206z. The resulting network is a series connection of μstacks 5200q to 5200s excluding μstack 5200p resulting in a fuel cell stack 36s120p.

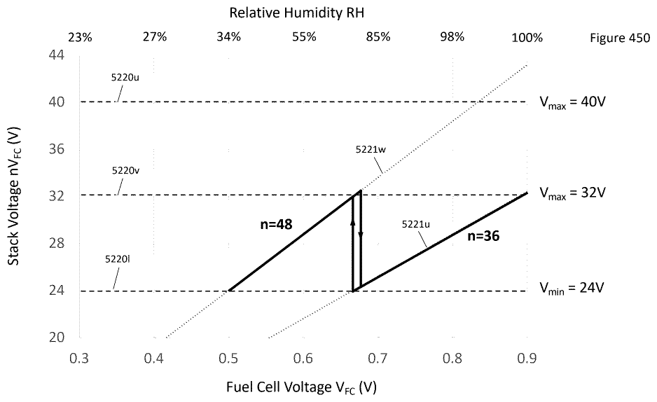

FIG. 450 illustrates the resulting transfer function of the n={36, 48}iBFC as described. In the high humidity case where V_{FC}>0.67V per layer, the fuel cell functions as a n=36 stack following curve 5221u between a maximum voltage 5220v of Vₘₐₓ=32V down to a minimum voltage 5220l of Vₘᵢₙ=24V. At this lower voltage, the dynamic fuel cell performs a state change increasing the array by one 12-layer μstack from n=36 to n=48 increasing the fuel cell stack back to the maximum voltage 5220v of Vₘₐₓ=32V.

For all voltages V_{FC}<0.67V the fuel cell follows the curve 5231w. At V_{FC}=0.5V/layer, the stack voltage drops to minimum voltage 5220l of Vₘᵢₙ=24V corresponding to a lower humidity level of RH=34%. As such, a two-state dynamic fuel cell comprising four 12s120p μstacks is able to operate from 34%-to-100% relative humidity over a membrane voltage range from 0.5V-to-0.9V while maintaining a fuel cell stack output voltage bounded between 24V-to-32V.

This performance is contrasted to a fixed n=48 fuel cell following the dotted line extension of curve 5221w which is limited by a 40V maximum to 24V minimum by humidity within the range of 34% to 98.4%. At 100% humidity the fixed array voltage will rise to 43V exceeding the specific maximum value. Exceeding 40V has several disadvantages including (i) it requires UL safety certification as a ‘high’ voltage system, (ii) it requires the use of more costly less efficient power MOSFETs, (iii) it generates more heat in the fuel cell, and (iv) it reduces the efficiency of the charge transfer regulator QXR controlling the energy transfer from the fuel cell to the buffer stack.

For example because the maximum voltage exceeds 40V, charging a buffer stack to 24V using linear charging is only η=24V/40V=60% efficient, meaning forty percent of the power transferred is burned in the charger as heat. While excessive power loss can be ameliorated by using a switching charger, the transient current capability of a fuel cell is limited by its high internal impedance. By minimizing the maximum voltage differential ΔV=(Vₘₐₓ−Vₙₒₘ) between the fuel cell stack and the buffer, charger inrush currents are also minimized, reducing the required current rating of the charger devices.

As stated previously aside from better managing transient currents, another unique benefit of the μstack architecture made in accordance with this invention is heat dissipation. By spreading the membrane generated heat losses across four μstacks, the concentration of heat losses is reduced by 75%.

### Wide Humidity 24V Fuel Cells.

To electrically expand the operational range of a fuel cell to function at lower humidity levels, a dynamic buffered fuel cell made in accordance with this invention comprises additional series μstacks connected into the series stack only under extremely dry conditions. These extra μstacks are disconnected at higher humidity conditions to avoid producing over-voltages. To tailor a dynamic fuel cell to cover the widest humidity range, a number of μstacks can be connected in series in varying numbers or combinations.

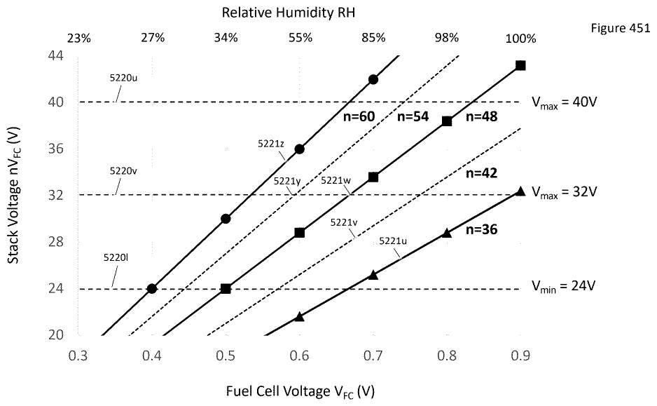

As shown in FIG. 451 the conduction characteristics for various twelve-layer μstacks shown by solid lines 5221u, 5221w, and 5221z corresponding to membrane counts of n=36, n=48, and n=60 respectively. Curves based on a lowest common denominator of six layers also include n=42 curve 5221v and n=54 curve 5221v. For maximum flexibility, six and twelve layer μstacks can be used in combination, while still only manufacturing two μstack variants. In most cases however, combining 12s120p μstacks is sufficiently versatile to accommodate a wide a range of applications. Of the curves shown, three configurations exceed the 40V maximum voltage limit 5220u within the specified range of fuel cell voltages. Specifically curve 5221w exceeds 40V when V_{FC}≥0.83V/layer or RH≥98.6%, curve 52214 exceeds 40V when V_{FC}≥0.74V/layer or RH≥90%, and curve 5221z exceeds 40V when V_{FC}≥0.67V/layer or RH≥73%. Notice the relationship between humidity RH and the single layer fuel cell voltage V_{FC} exhibits a non-linear characteristic. Although the relationship is chemistry specific, in the example shown the humidity variation is greatest in the range where 0.6V <VFC <0.7V.

Similarly all curves shown drop below the minimum voltage 5220l of 24V within the specified range. Specifically the five curves 5221u, 5221v, 5221w, 5221y, and 5221z reach minimum voltage 5220l at per layer voltages of 0.67V, 0.57V, 0.5V, 0.44V, and 0.4V respectively, roughly corresponding to relative humidity values of 78%, 50%, 34%, 30%, and 27%. Clearly the higher membrane counts of n 48 layers work at lower membrane voltages and humidity levels but exhibit too much voltage at normal humidity ranges. Conversely fuel cells where n 42 avoid the overvoltage problem but can't function in dry air when RH≤50%. To overcome this conflict, the dynamic buffered fuel cell made in accordance with this invention employs a switched array of fuel cell μstacks. This method is much more flexible and less costly than adjusting the number of active layers within one fuel cell stack.

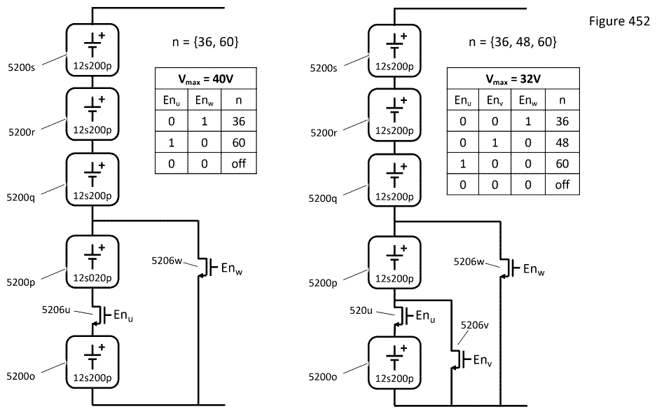

As shown in FIG. 452, fuel cells comprising five 12-layer μstacks can be combined in a variety of versatile ways. For example, in the dynamic FC construct n={36,60} shown on the left, a series of μstacks 5200o through 5220s are connected in series with a series MOSFET switch 5206u connected the network branch containing series μstacks 5200o and 5200p with bypass MOSFET switch 5206w. The enable gate input for series MOSFET switch 5206u is labelled as En, while the gate input for bypass MOSFET switch 5206w is labelled as En_{w}.

As depicted for the dynamic FC labelled n={36,60} shown on the left, the corresponding truth table contains three allowed states. In the case (Enᵤ, En_{w})=(0, 0) both transistors are in their open off state and the fuel cell stack is cutoff. When signals (Enᵤ, En_{w})=(0, 1) pass-transistor MOSFET 5206u is cutoff disconnecting μstacks 5200o and 5200p from the stack but bypass transistor 5206w is activated. The resulting fuel cell comprises a fuel cell stack where n=36. When signals (Enᵤ, En_{w})=(1, 0) bypass transistor 5206w is disabled but pass MOSFET switch 5206u is active inserting μstacks 5200o and 5200p into the network whereby n=60. As such, the fuel cell stack may comprise an array where the number of membranes ‘n’ may comprise 60, 36 or zero (off).

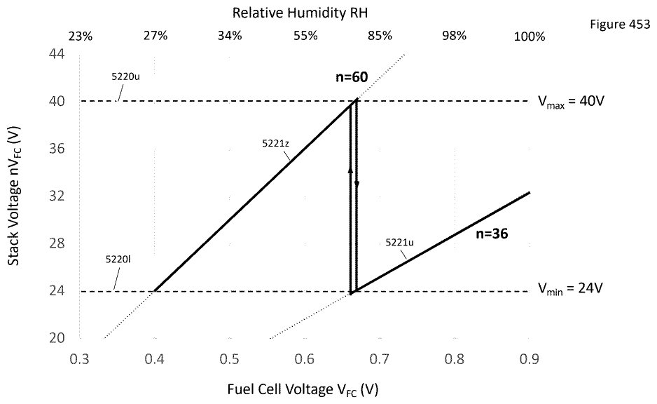

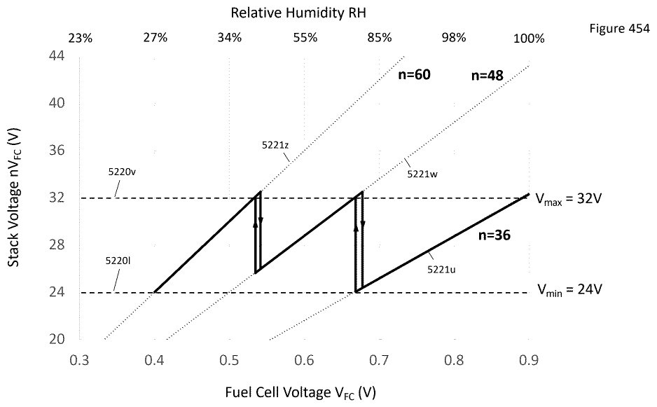

The output characteristics of this two state fuel cell stack is illustrated in FIG. 453. As shown when fuel cell voltage V_{FC}≥0.67V corresponding to relative humidity levels exceeds 80% the fuel cell stack comprises a series connection of three μstacks. This configuration where n=36 follows curve 5221u spanning the voltage range from 32V down to a minimum value 5220l of Vₘᵢₙ=24V. For fuel cell voltage V_{FC}<0.67V corresponding to relative humidity levels below 80% the fuel cell dynamically switches to n=60 corresponding to curve 5221z. The resulting conduction characteristics span the voltage range from the maximum value 5220u where Vₘₐₓ=40V to a minimum value 5220l of Vₘᵢₙ=24V. This design is advantageous in that it function down to a fuel cell voltage of 0.4V/layer corresponding to RH=27% but exhibits a peak stack voltage of 40V.

In order to minimize the maximum voltage of the five μstack array, an additional state must be added. Returning to FIG. 447, in the configuration n={36, 48, 60} a three MOSFET switch network is used to control a FC μstack network by three digital signals: En_{w} controlling the gate of bypass MOSFET switch 5206w, Enᵥ controlling the gate of bypass MOSFET 5206v, and Eᵤ controlling the gate of series pass MOSFET 5206u. Of the various combinations articulated in the corresponding three-input truth table, only four combinations are allowed, one of which is the degenerate case (Enᵤ, Enᵥ, En_{w})=(0, 0, 0) when the fuel cell is disconnected.

In the combination where input (Enᵤ, Enᵥ, En_{w})=(0, 0, 1), only bypass MOSFET switch 5206w is active whereby the fuel cell comprises μstacks 5200q, 5200r, and 5200s and the aggregate fuel cell stack comprises n=36 layers. In the combination where input (Enᵤ, Enᵥ, En_{w})=(0, 1, 0), only bypass MOSFET switch 5206w is active whereby the fuel cell comprises four μstacks, namely 5200p, 5200q, 5200r, and 5200s, and n=48. Lastly, In the combination where input (Enᵤ, Enᵥ, En_{w})=(1, 0, 0), only pass-through MOSFET switch 5206wu is active comprising all five μstacks for a net fuel cell stack comprises n=60. The resulting characteristics are shown in the curves of FIG. 454, where operation occurs in three bands, namely
V_{FC}≥0.67V corresponding to a relative humidity range RH≥80% where n=36 and the curve 5221u maintains operation within a 8V span from Vₘₐₓ=32V to Vₘᵢₙ=24V;
0.67V≥V_{FC}≥0.53V corresponding to a relative humidity range 80%>RH≥39% where n=48 and the curve 5221w maintains operation within a 6V span from Vₘₐₓ=32V to Vₘᵢₙ=26V;
0.53V≥V_{FC}≥0.4V corresponding to a relative humidity range 39%>RH≥27% where n=48 and the curve 5221z maintains operation within a 8V span from Vₘₐₓ=32V to Vₘᵢₙ=24V;
In a fourth band where V_{FC}<0.4V and relative humidity RH≤27%, the voltage of fuel cell stack falls below Vₘᵢₙ=24V and is unreliable at charging the buffer stack to full charge. This does not mean that no charging is possible but the minimum buffer voltage is limited to 3V/cell×6 cells or 18V to prevent over-discharging of Li-ion cells. As such, limiting buffer charging between the fuel cell output voltage and 18V.

The following table compares 24V fuel cell modules comprised of dynamically controlled series-connected μstacks to that of a single fuel cell:

| Parameter | Fixed Array | Dynamic Array | |
|---|---|---|---|
| FC topology | fixed, n = 48 | n = 36, 48 | n = 36, 48, 60 |
| Number of stacks | 1 | 3, 4 | 3, 4, 5 |
| Target | 24 V | 24 V | 24 V |
| voltage Vₙₒₘ | | | |
| Voltage range | 19 V to 43 V | 24 V to 32 V | 24 V to 32 V |
| (over RH range) | | | |
| Humidity range | 34% to 98.4% | 34% to 100% | 27% to 100% |
| Self heating | concentrated (+6X) | reduced (−75%) | reduced (−85%) |
| Regulator | Buck converter | none required | none required |
| for V ≥ Vₙₒₘ | | | |

Advantages of the dynamic fuel cell using a switched array of FC μstacks made in accordance with invention include the following:
maintains a minimum output voltage of 24V over a wide range of operating conditions
limits the maximum voltage of a fuel cell stack to a defined voltage such as 40V or 32V
operates over a wide range of humidity levels from 100% down to 34% extendable down to 27% with a minor increase in component count
eliminates the need for a Buck or Buck-boost converter to charge a battery stack or buffer
reduces heating within a fuel cell by up to 80%

The enumerated advantages of a dynamic fuel cell comprising a switched array of FC μstacks over conventional fuel stack designs are significant in reducing heat, expanding the operating range, and improving reliability. No similar dynamic fuel cell design exists in the literature or in the market.

### Heavy Duty Buffered Fuel Cell.

Another consideration of a fuel cell is instantaneous power output, referred to herein as “on-demand power”. The ability of a buffered fuel cell to deliver high currents to a load depends on a number of factors namely:
the voltage differential between the fuel stack voltage and the voltage of the electrical load being powered which is a function of the number of membranes per μstack, the number of μstacks connected in series, and ambient conditions such as temperature and humidity;
the transient and steady-state current demand of the load;
the thickness and composition of the ionomeric membrane;
the active area of the ionomeric membranes A_{FC};
the membrane current density I_{FC}/A_{FC} e.g. 215 mA/cm²;
current limiting imposed by the charge transfer regulator (QXR);
the number of parallel strings of battery buffer cells; and
parasitic resistances such as pass-through MOSFETs in the fuel cell array and access MOSFETs in the buffer load access circuit.

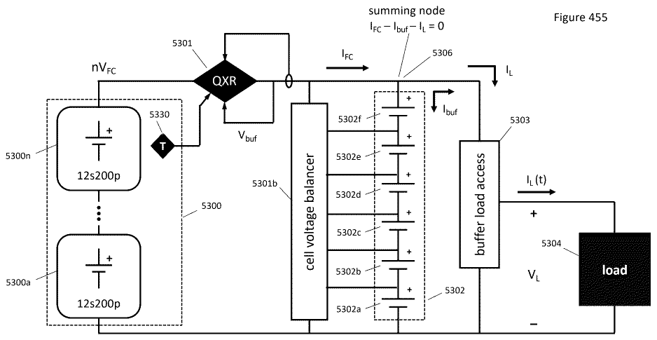

To analyze the relative contributions of these electrical elements in determining the on demand power capability of a given design buffered fuel cell made in accordance with this invention, the power-switch-load topology must be carefully considered. As shown in FIG. 455, a topological diagram of an iBFC comprises a series string of ‘n’ μstacks 5300a through 5300n, collectively as fuel cell stack 5300 which may be static or dynamically reconfigurable; a charge transfer regulator QXR controlling energy flow out of the fuel cell stack; an electrical buffer in this example comprising a series array of lithium ion batteries 5302a through 5302f, collectively comprising buffer 5303; and buffer load access (BLA) circuit 3203 protecting the electrochemical buffer from damage potentially caused by load 5304. Cell voltage balancer 5301b also maintains the buffer cells at the same voltage.

In operation, charge transfer regulator QXR 5301 employs both voltage and current feedback to control the current flowing between the fuel cell stack 5300 and buffer 5302. The current feedback performs two tasks (i) to prevent excessive current from being drawn from the fuel cell stack 5300 causing the stack voltage nV_{FC} to sag or collapse, and (ii) preventing excessive charging current to flow into buffer 5302 potentially damaging or overheating the electrochemical cells. The value of current transferred may comprise (i) a prefixed value matched to the specific fuel cell stack; (ii) a programmable current adjusted in response to instructions from a iBFC microcontroller, e.g. according to environmental, system, or load requirements; (iii) a two-step response corresponding to different current densities required during steady-state and transient operation; (iv) a feedback controlled current limit adjusted by monitor the temperature in one or more fuel cell μstacks using temperature sensor 5330; or (v) combinations thereof.

While QXR 5301 controls energy transfer between the fuel cell stack 5300 and buffer 5302 the, buffer load access circuit 5303 protects the buffer 5302 from an electrical load 5304 by limiting the peak current output during discharging and preventing the buffer from over-discharge, i.e. when its voltage drops so low that damage can occur to the battery's internal separator film. As shown the current I_{FC} flowing out of fuel cell 5300 and through QXR 5301 is summed with the current I_{buf} from buffer array 5302 and delivered to the electrical load through the buffer load access circuit 5303 as load current IL to electrical load 5304 whereby

$${I}_{L} = {I}_{F C} + {I}_{buf}$$

In this circuit particular iBFC topology, the QXR fuel cell current I_{FC}, buffer current I_{buf}, and load current all connect to summing node 5506, and always balance to a net zero node current. While the fuel cell output current I_{FC} and the iBFC's load current IL are both positive numbers, the polarity of the buffer current I_{buf} may be positive or negative—positive during discharging, negative during recharging. From the above equation it follows that during discharge when the buffer current is positive, the load current can exceed the fuel cell's output, i.e. I_{L}>I_{FC}. Conversely when the buffer is charging and fuel cell current I_{buf}<0 is negative, a portion of the fuel cell's current is diverted from the load to the buffer reducing the power available to an electrical load.

One role of the buffer cell is to smooth out the current fluctuations by supplying extra current to a load when needed and recharging itself when the energy supply exceeds demand. Since periods of high demand are limited in duration, e.g. less than 10 seconds, the transient current rating of a heavy-duty buffered fuel cell (HD iBFC) can greatly exceed its continuous current rating. The expanded operating range however requires a change in the topological circuit for the HD iBFC compared to the standard buffered fuel cell described herein.

It should be noted unlike in conventional battery packs where a battery disconnect switch (BDS) prevents its batteries both overcharging and over-discharging, in the buffered fuel cell made in accordance with this invention the responsibility for protecting the buffer cells is split between the charge transfer regulator and the buffer load access circuit. As shown, charge transfer regulator QXR 5301 controls the charging rate and prevents overcharging of the buffer 5302, while the role of the buffer load access (BLA) 5303 is to prevent over-discharging of the buffer and over-discharging the battery cells. The BLA also protects against reverse charging where the electrical load acts as a power source and attempts to charge the buffer by having its load current flow into rather than out of the output of the buffered fuel cell.

The necessity of the split protective functions is obvious topologically. The charge transfer regulator 5201 can only control energy flowing from the fuel cell stack 5300 into battery buffer 5302 because it is interposed between the two. It has no ability to protect the buffer 5302 from electrical load 5304 because it is not located between them. Protecting buffer 5302 from the load is entirely the purview of the buffer load access circuit. Conversely, because the buffer load access circuit 5303 is interposed between load 5304 and buffer 5302, it has no control over charging of the buffer from fuel cell 5300. This distinction is completely different from the battery disconnect switch in a lithium ion battery pack which integrates all cell protection functions aside from charging and cell balancing.

Reiterating, the conventional buffered fuel cell contains a summing node 5306 where the inbound and outbound currents of the fuel cell stack, the buffer, and the load converge. Ostensibly, in the absence of any interference from charge transfer regulator QXR 5301 or buffer load access BLA 5303 circuitry, under normal operation the three blocks of the standard iBFC shown in FIG. 450, namely fuel cell stack 5300, buffer 5302, and load 5304 are essentially wired in parallel. In normal iBFC operation the load 5304 draws current from the buffer 5302, and the fuel cell 5300 recharges the buffer 5302 of the charge it lost.

The net function of the disclosed iBFC s therefore is that of a self recharging battery where the load is completely disconnected from and unaware of the presence of the fuel cell. Likewise the fuel cell never sees the current demand of the load or even aware of its power demands except that it detects when the buffer voltage decays with a lower state-of-charge (SoC). While this architecture of self recharging battery is essentially fool proof from a user perspective, it suffers one major drawback—it cannot invoke extra current capacity of the fuel cell to help supply high current load transients because the charge transfer regulator prevents it from doing so.

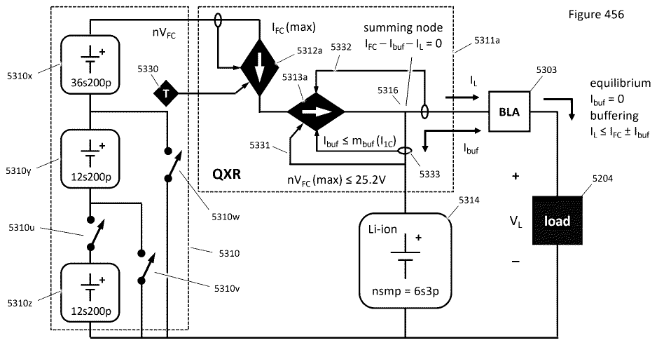

This limitation is better understood by considering the standard buffered fuel cell disclosed herein in the schematic form of FIG. 456. For simplicities sake, the buffer load access circuit is removed, the charge transfer regulator 5311a is expanded into its constituent subcomponents and the fuel cell is illustrated as a dynamic topology containing three μstacks and three switches. More specifically 36s120p μstack 5310x is connected in series with two 12s120p μstacks 5310y and 5310y with a single intervening switch 5310u. The switch is likely implemented using a low voltage power MOSFET such as a DMOS or trench DMOS as a discrete component or integrated into an integrated circuit. Additional bypass switches include 5310w and 5310v. In practice, 36s120p μstack 5310x actually comprises three series connected μstacks each using an identical a 12s120p μstack design.

In this manner the fuel cell stack comprises five 12s120p μstacks selectable in combinations of n={0, 236, 48, 60} layers.

If all three switches are open, no complete circuit path exists in the fuel cell and the device is off. If bypass switch 5310x is conducting and the other switches are off then all the power is generated in 36s120p μstack 5310x and n=36. If bypass switch 5310v is conducting and the other switches are off then all the power is generated in the series connected 36s120p μstack 5310 and 12s120p μstack 5310y and n=48. If both bypass switches are open and pass-through switch 5310u is closed then the all three μstacks 5310x, 5310y, and 5310z are conducting whereby n=60.

Regardless of the voltage nV_{FC} of the dynamic stack the entirety of the stack's current is fed into charge transfer regulator QXR 5311a comprising two competing dependent current regulators—current source 5312a designed to protect the fuel cell from excessive current and voltage sag, and current source 5313a designed to properly charge the buffer cells 5314. The current source 5313a terminates into the aforementioned summing node 5316 along with buffer 5314 and load 5204.

To reiterate the role of charge transfer regulator 5311a is threefold, (i) to prevent excessive current from being drawn from the fuel cell stack 5310, (ii) to prevent excessive charging current to flow into buffer 5314, and (iii) to prevent charging the buffer to an unsafe voltage, all while meeting the minimum current requirement for the load. Since the maximum load current I_{L}(max) can be limited by BLA 5303, the maximum fuel cell demand is known and the fuel cell be designed accordingly.

In FIG. 456, QXR 5311a is depicted as two series-connected dependent current sources 5312a and 5313a one controlling the fuel cell current I_{FC} flowing out of fuel cell stack 5310, the other controlling the aggregate of current IL flowing to the load 5204 and the charging current I_{buf} flowing into buffer array 5314. Since the current flowing out of QXR 5311a to the load and buffer array connect to a common summing node 5316, there is no way to separate the two currents. Because the current in a network branch can only be controlled by one current source, the schematic representation of QXR 5311a as two-series connected current sources is illustrative only, to help distinguish criteria of fuel cell conduction separately from that of buffer and load currents.

The first criteria, preventing excessive currents from flowing from fuel cell stack 5310 depends on the active area A_{FC} of the fuel cell membranes and the design criteria of a safe current density [I_{FC}/A_{FC}]. Selection of a target current density [I_{FC}/A_{FC}] is an iterative process because fuel cell voltage is a function of current density, i.e. V_{FC}=f([I_{FC}/A_{FC}]). Specifically higher current densities reduce a fuel cell's voltage. Despite the voltage sag phenomena, higher current densities also beneficially result in a higher output power but adversely impact self heating, temperature, and reliability. While current densities may run between 200 mA/cm² and 1000 mA/cm², reliability and overheating concerns favor lower current densities, e.g. where [I_{FC}/A_{FC}]=215 mA/cm². As one option, higher current values for current source 5312 can be programmed either by limiting their duration, e.g. conducting [I_{FC}(10 s)/A_{FC}]=430 mA/cm² for up to 10 seconds during a load transient, or by limiting the current in accordance with the fuel cell temperature detected by sensor 5330.

In order to calculate the fuel cell voltage V_{FC} at a specific current, the precise relationship between fuel cell voltage and current density must be known in advance. To define the V_{FC} versus I_{FC} response surface over variations in temperature and relatively humidity requires an ionomeric polymer must first be fabricated and characterized. Such a curve is often referred to as a polarization curve, a technical misnomer as polarization phenomena is only one of several energy loss mechanisms determining the V_{FC}−I_{FC} relation. In fact because the depends on the chemistry of the polymer and the fabrication process used to synthesize it, there is no practical means available today to accurately simulate or predict this voltage-current behavior a priori. Once the current density and membrane size is decided, the maximum current of the fuel cell I_{FC}(max) and the instantaneous power output capability of the fuel cell stack is set.

In QXR 5311a operation, any current demand exceeding the specified maximum current value will be electronically limited by current source 5310a. Accordingly the current capability of the fuel cell has a maximum value of I_{FC}(max)=A_{FC} [I_{FC}/A_{FC}] with a corresponding maximum power output of P_{FC}(max)=V_{FC} I_{FC}(max)=V_{FC}A_{FC}[I_{FC}/A_{FC}] where V_{FC} is a function of current. For example, if [I_{FC}/A_{FC}] is selected to be 215 mA/cm² at V_{FC}=0.7V per layer, for a fuel cell with A_{FC}=200 cm² then the maximum fuel cell current is

$${I}_{F C} ( max ) \leq {A}_{F C} [ {I}_{F C} / {A}_{F C} ] = ( 200 {cm}^{2} ) [ 215 mA / {cm}^{2} ] = 43 A$$

As such, the current limit value for current source 5312a can be present to 43 A.

With a nominal μstack voltage of n_{μs}V_{FC}=(12)(0.7V)=8.3V for a fuel cell μstack having n_{μs}=12 layers, the corresponding peak power output P_{μs}(max) is

$${P}_{μ s} ( max ) \leq {n}_{μ s} ( {V}_{F C} ) ( {I}_{F C} ( max ) ) = 12 ( 0.7 V ) ( 43 A ) = ( 8.3 V ) ( 43 A ) = 361 W$$

For a three μstack array this corresponds to an output voltage n_{FC}V_{FC}=3n_{μs}V_{FC}=3(8.3V)=25V, a voltage slightly below the Li-ion safe operating area (SOA) limit of 25.2V total or 4.2V per cell. At a voltage of 25V, the fuel cell output includes voltage headroom (V_{FC}−V_{buf}) needed for charging the buffer array to a nominal voltage of n_{FC}V_{FC}=23.3V via current limiter 5313a. During charging, as the buffer approaches its terminal value the voltage differential (V_{FC}−V_{buf}) declines and the charging current approaches zero.

In constant voltage (CV) mode charging, a comparator monitoring the buffer voltage by feedback 5331 may be programmed to discontinue charging at a lower voltage, e.g. at n_{FC}V_{FC}=23.3V thereby avoiding any safety risks associated with exceeding a Li-ion overcharge voltage V_{OC} safety limit. Another benefit for discontinuing charge below 4.2V per cell is that battery life studies show that not charging a Li-ion cell to its capacity, i.e. for SoC<100%, has been found to improve the cycle life and use life of the electrochemical cells. In such as case, the output of buffer current limiter 5313a limits the voltage to the nominal fuel cell stack voltage of m_{FC}(V_{FC})=23.3V or V_{FC}=3.88V per cell in which case the power output of each μstack is limited to

$${P}_{μ s} \leq {m}_{μ s} ( {V}_{F C} ) ( {I}_{F C} ( max ) ) = 12 ( 0.65 V ) \{ 43 A ) = ( 7.8 V ) \{ 43 A ) = 335 W$$

and the fuel cell delivers a total power of

$${P}_{μ s} \leq {m}_{F C} ( {V}_{F C} ) ( {I}_{F C} ( max ) ) = 36 ( 0.65 V ) ( 43 A ) = ( 23.3 V ) ( 43 A ) = 1000 W$$

The second criteria for the QXR, to avoid excessive charging currents in the battery is determined by the manufacturer-specified maximum charging C-rate of the cells and the number of parallel strings m_{buf} in the battery buffer but not by the number of buffer cells n_{buf} in series in each string. If we define the max charge rate as [I_{chg}(max)] then the maximum current safely delivered by the current limit for current source 5313

$${I}_{c h g} \leq ( {m}_{buf} ) [ {I}_{c h g} ( max ) ] \approx ( {m}_{b u f} ) [ {I}_{1 C} ]$$

If we assume a maximum charge rate for a Li-ion cell to be 1 C, then for a 3200 mA Li-ion cell the current limit for a single string of six 18650 lithium ion batteries is

$${I}_{c h g} ( max ) \leq ( {m}_{buf} ) [ {I}_{c h g} ( max ) ] = ( {m}_{buf} ) [ {I}_{1 C} ] = ( 1 ) [ 3.2 A ) ] = 3.2 A$$

and is 6.4 A for a two-string pack where m_{buf}=2, 9.6 A for a three-string pack where m_{buf}=3, 19.2 A for a six-string pack where m_{buf}=6, and so on.

Since in an iBFC with a single summing node the net current is always governed by KCL to be I_{FC}−I_{buf}−I_{L}=0, then when I_{L}=0 the charging current is equal to the fuel cell current, i.e. I_{FC}=I_{buf}. This condition means in a QXR comprising a single charge transfer regulator, the maximum fuel cell current cannot exceed the maximum safe charging current so I_{FC}≤I_{buf}(max). Made in accordance with this invention, when the rated charging current of a buffer I_{chg}(max) greatly exceeds the current handling ability of a fuel cell, i.e. when I_{chg}(max) >>I_{FC}(max) or more precisely when

$$( {m}_{buf} ) [ {I}_{c h g} ( max ) ] >> [ {I}_{F C} / {A}_{F C} ]$$

then the fuel cell current I_{FC}(max) needs to be limited to prevent voltage collapse by selecting a value well below the maximum charging C-rate of the cell. In such cases, buffer current source 5313a can be eliminated and the current limiting of current source 5312a may suffice to protect both fuel cell and buffer, in essence because the fuel cell is too small to harm the buffer. As the equation suggests, this condition occurs only for extremely small fuel cells or those incapable of operating at higher current densities or when driving extremely large buffers from a small fuel cell, a condition referred to as trickle charging. Such cases may however occur in mobility solutions especially those in avionics and space such as drones, aircraft, spacecraft, and satellites.

The disadvantage of this approach is that the majority of the load current I_{L} must be supplied by the buffer, not the fuel cell. In other words, during a load condition when I_{L}>I_{FC}(max) the buffer must make up the difference as the fuel cell is limited in its current capability. In such case, the load current can be expressed as

$${I}_{L} = {I}_{F C} ( max ) + {I}_{buf}$$

so long that buffer cell array doesn't run out of stored charge Q_{buf}. Rearranging the charge-rate equation C-rate=±(I_{buf}/Q_{buf}) where C-rate has units of inverse hours, i.e. h⁻¹ and Q_{buf} has units of coulombs or ampere-hours (Ah or mAh), results in two polarities of buffer current: positive current I_{FC}>0 flowing from the fuel cell into the buffer during charging, and negative current I_{FC}<0 flowing from the fuel cell to the load during discharging.

$${I}_{buf} = + ( CCR ) ( {Q}_{buf} ) for charging$$

$${I}_{buf} = - ( CDR ) ( {Q}_{buf} ) for discharing$$

For lithium ion cells, a C-charging rate of CCR=1 is nominal as faster charging can irrevocably damage cells. For discharging C-discharging rates of CDR=1 to CDR=2 are not uncommon. During discharging, the load current as a function of charge storage can be expressed as

$${I}_{L} = {I}_{F C} ( max ) + {I}_{buf} = {I}_{F C} ( max ) + ( CDR ) ( {Q}_{buf} )$$

One major disadvantage of a fixed-current-limit design implementation is the performance of the iBFC when the usable buffer charge is depleted, i.e. Q_{buf}=0 and I_{buf}=0 in which case

$${I}_{L} = {I}_{F C} ( max ) + {I}_{buf} = {I}_{F C} ( max )$$

In other words, when the buffer current capability greatly exceeds that of fuel cell currents, in a fixed current limit design the only available current when the buffer is depleted is the current-limited fuel cell output I_{FC}(max). During design, care must be maintained to ensure this current is adequate for the load's continuous power consumption plus some surplus power needed to recharge the buffer in a reasonable time. The minimum fuel cell output current must thereby exceed

$${I}_{FC} ( max ) > {I}_{L} + ( CCR ) ( {Q}_{buf} )$$

Assuming a 10 A load and a Q_{buf}=20 Ah buffer, a 3-hour recharge rate (CCR=0.33) requires a fuel cell capable of currents I_{FC}(max)>I_{L}+(CCR)(Q_{buf})=10 A+(0.33/h)(20 Ah)=16.5 A. If however the load current IL exceeds I_{FC}(max)−I_{buf}(chg), the buffer will not ever find time to recharge. As such, the iBFC will suffer a net energy deficit ultimately where the only power available from the iBFC is limited to the fuel cell's output. In alternative design, a higher current fuel cell is used to drive a much smaller buffer array, whereby

$${A}_{FC} [ {I}_{F C} / {A}_{F C} ] >> ( {m}_{buf} ) [ {I}_{c h g} ( max ) ]$$

In such a design the fuel cell current I_{FC} greatly exceeds the ability of the buffer array from conducting, absorbing, and storing the fuel cell generated charge without risking overheating and damage, i.e. I_{FC}>I_{chg}(max). Given the KCL condition at the summing node 5316

$${I}_{F C} - {I}_{buf} - {I}_{L} = 0$$

then in a light load or no load condition where I_{L}≈0,

$${I}_{F C} \leq {I}_{buf} ( max )$$

meaning in a single current limiter architecture, the maximum fuel cell current is limited by the buffer 5313a. Applying this condition to the load current equation has a peak power-on-demand current output

$${I}_{L} = {I}_{F C} + {I}_{buf} ( max ) = ( {I}_{buf} ( max ) ) + {I}_{buf} ( max ) = 2 {I}_{buf} ( max )$$

For example, a m=200 fuel cell capable of 42 A combined with a 9 A buffer is only capable of 18 A while discharging the buffer. After buffer discharge, the current output drops to 9 A meaning the 42 A fuel cell capacity is totally wasted.

In one embodiment the buffer array 5314 can be electrically disconnected from the summing node 5316 by a power switch such as a power DMOSFET once it is charged and reconnected only when I_{L}>I_{FC}. Although this method allows the iBFC current to exceed the buffer charging current I_{buf}(max), it can lead to voltage discontinuities and instabilities.

In more reasonable cases where the two fuel cell and buffer currents are comparable both current limiters 5312a and 5313a may be required whereby the circuit must sense, detect, and adjust the current to the applicable limit dynamically as operating condition or circuit topologies change, e.g. in high load or sleep mode conditions. Current limiter 5312a sets the current I_{FC}(max) from the fuel cell stack. As a dependent source the current limit value can be programmed at multiple values for example at [I_{FC}/A_{FC}]=200 mAcm² during steady-state mode and [I_{FC}(PoD)/A_{FC}]=400 mAcm² during power-on-demand mode. Output current limiter 5316a controls the summing node current. In order to deliver the requisite output current IL to load 5204 and not overcharge buffer array 5314, it is necessary for the dependent current source 5313a to monitor the output current 5332 and to simultaneously to monitor the buffer array current 5333.

A summary of the dynamic QXR function is shown in the following table illustrating five different operating mode for the iBFC.
Fully Charged—In the fully charged condition, the net buffer current is zero, I_{buf}=0 so there is no charge in the charge state, ΔQ_{buf}=0 meaning Q_{buf}=Qₘₐₓ or SoC=100%. During the condition as long a the fuel cell matched the load current I_{FC}=I_{L} the buffer charge state will remain constant.
Charging—During charging the state of charge SoC of the buffer is increasing ΔQ_{buf}>0 by an amount ΔQ_{buf}=ΣI_{buf}Δt or more accurately ΔQ_{buf}=∫I_{buf}(t) dt, a condition that only occurs when the fuel cell current I_{FC} is greater than the load current I_{L} so that I_{FC}>I_{L}. The charging mode can be subdivided into two cases, I_{FC}<I_{FC}(max) and I_{FC}=I_{FC}(max), i.e. whether the fuel cell is operating at is maximum current density. When I_{FC}<I_{FC}(max) then the current available to charge the buffer is given by I_{buf}=(I_{FC}−I_{L})=+(CCR)(Q_{buf}) as set by the C-charging rate CCR, typically at CCR=1. In a second case, the current demand from the combined requirements of the load and the buffer are greater than the fuel cell can supply so the current limiter regulates the current to its maximum value I_{FC}=I_{FC}(max). In this case the available current for charging the buffer is I_{buf}=(I_{FC}(max)−I_{L})=+(CCR)(Q_{buf}) where CCR<1, meaning the charging rate is slowed down by an excessive load current I_{L}. Note than during charging I_{buf}21 >0 is a positive number so that in the KCL summing node equation I_{FC}−I_{buf}=I_{L} a positive value buffer current means a portion of the fuel cell current is diverted from the load to charge the buffer. Through feedback, however, the current source detects the shortfall and increases the value of I_{FC} accordingly to maintain charge neutrality as long as the current does not exceed I_{FC}(max). If the maximum fuel cell current limit is reached then the charging rate necessarily must be sacrificed to ensure the load current demand I_{L} is satisfied.
Equilibrium—The equilibrium or ‘steady state’ occurs when the load current precisely matches the maximum allowable fuel cell current whereby I_{L}=I_{FC}(max). In such a condition, the fuel cell cannot provide any additional current for charging or refreshing the buffer whereby I_{buf}=0 and ΔQ_{buf}=0 meaning the state of charge of the buffer remains as it is without replacing any missing charge.
Charging—During discharging the load current exceeds the fuel cell's maximum output I_{L}>I_{FC}(max) so that the buffer must make up the current deficit I_{buf}=−(I_{FC}−I_{L}) by releasing its stored charge. Because of the load demand, the buffer's state of charge SoC of the buffer declines ΔQ_{buf}<0 in an amount I_{buf}=−(I_{FC}−I_{L})=−(CDR)(Q_{buf}) stipulated by the C-discharge rate CDR, typically where 0.5≤CDR≤2 meaning the power on demand interval where extra current is available is limited to between 2 hours down to 30 minutes. The negative sign for I_{buf} means in the KCL charge summing equation I_{L}=I_{FC}+I_{buf} the fuel cell and buffer both contribute to supplying the load. In the event, however, that the fuel cell current reaches its maximum current limit I_{FC}(max) the buffer current I_{buf}=−(I_{FC}(max)—I_{L})=−(CDR)(Q_{buf}) must necessarily increase to make up the difference, meaning the C-discharge rate CDR will unavoidably increase. The consequences of an excessive current draw on the buffer vary including scenarios of (i) the excessive demand is temporary and the buffer current falls back into its normal CDR range; (ii) the excessive current causes damage to the buffer; (iii) the iBFC is unable to meet the load current demand causing a malfunction and load disconnect by the BLA circuit; or (iv) the iBFC shuts down to protect the buffer causing a system malfunction. Because the iBFC module is intelligent, the high load fault condition can be detected and a message sent to the system asking for the load to throttle back on its power demand.
Fully Discharged—In the fully discharged case, the buffer has been discharged to its lowest allows state-of-charge, i.e. where Q_{buf}=Qₘᵢₙ at which point the buffer can no longer assist in meeting load demands whereby I_{buf}=0 and therefore I_{L}=I_{FC} or I_{L}=I_{FC} (max) depending on the load condition. If this current is too low a system fault as described above will result whereby the system may either shutdown or send a warning by its communication bus or network to the system asking for reduced load current demand.

These operating modes are summarized in the following table describing the operating mode (buffer charged, charging, discharged), net change in the buffer charge, fuel cell current, buffer current, and load (output) current of the iBFC.

| Operating | Buffer Charge | Fuel Cell | Buffer | Load |
|---|---|---|---|---|
| Mode | State ΔQ (Ah) | Current I_{FC} | Current I_{buf} | Current I_{L} |
| fully | Q_{buf} = Qₘₐₓ, | I_{FC} | 0 | I_{FC} = I_{L} |
| charged | ΔQ_{buf} = 0 | | | |
| charging | ΔQ_{buf} > 0 | I_{FC} | (I_{FC} − I_{L}) = | I_{FC} > I_{L} |
| | | | +(CCR)(Q_{buf}) | |
| | | I_{FC}(max) | (I_{FC}(max) − I_{L}) = | |
| | | | +(CCR)(Q_{buf}) | |
| equilibrium | ΔQ_{buf} = 0 | I_{FC}(max) | 0 | I_{FC} = I_{L} |
| discharging | ΔQ_{buf} < 0 | I_{FC} | −(I_{FC} − I_{L}) = | I_{L} > I_{FC} |
| | | | −(CDR)(Q_{buf}) | |
| | | I_{FC}(max) | −(I_{FC}(max) − I_{L}) = | |
| | | | −(CDR)(Q_{buf}) | |
| fully | Q_{buf} = Qₘᵢₙ, | I_{FC} | 0 | I_{L} = I_{FC} |
| discharged | ΔQ_{buf} = 0 | I_{FC}(max) | | |

It should be understood by those skilled in the art that the dual function current limit function represented by series current sources 5312a and 5313a shown in FIG. 456 doesn't necessarily require two separate pass elements of control circuits but may involve a single power device such as depicted by current source 5301 shown in FIG. 455 whose current and voltage sensing, signal feedback, and gate drive are intelligently adjusted to protect the fuel cell and the buffer, whichever is more at risk at the time.

Another protective function of charge transfer regulator 5311a is its voltage clamping ability. In operation voltage feedback from the output of QXR 5201 monitoring the buffer string voltage prevents the overcharging buffer cells to an overvoltage condition V_{buf}>V_{buf}(max)/n_{buf}. Charging of an electrochemical cell or battery beyond its maximum specified voltage can cause electrolyte leakage, fire, or possibly explosion depending on the cell's chemistry. For lithium ion this voltage is approximately 4.2V per cell. Other cell balancing circuitry is required to make sure all series connected cells maintain the same voltage irrespective of the state-of-charge. These functions are described in an associated application entitled “Intelligent Buffered Fuel Cell with Low Impedance” and will not be elaborated upon here.

While the charge transfer regulator design of FIG. 456 necessarily limits the fuel cell's contribution in supplying high transient load currents, the transient performance of the Li-ion buffers provide some assistance. Specifically, unlike the 1 CCR=C limited charging rate of a Li-ion cell, the maximum discharge rate of the cells is significantly higher, for brief intervals even as high as CDR≤10 C. If we assume a maximum discharge rate for a Li-ion cell to be 10 C, then for a 3200 mA Li-ion cell the discharge current limit for a single string of six 18650 lithium ion batteries is 32 A as given by

$${I}_{buf} ( max ) \leq ( {m}_{buf} ) [ {I}_{10 C} ] = ( 1 ) [ 32 A ) ] = 32 A$$

and is 64 A for a two-string pack where m_{buf}=2, and 96 A for a three-string pack where m_{buf}=3, and so on. To facilitate conduction at such as high rate two possible implementations may be employed to realize the high current dynamic QXR function, either (i) detect the current spike and increase the CDR limit from 2 C to 10 C for a duration of 10 seconds after which the current limit is returned to 2 C; or program the default value of the current limiter to be CDR=10 C and upon detecting a transient start a 10 second timer after which the CDR value is reduced to 2 C. Alternatively the buffer load access circuit can disconnect the load as a short circuit detection for any current exceeding the 10 C limit. As one embodiment of the iBFC, by combining the fuel cell, QXR, and buffer array into the iBFC three possible operating conditions can be realized, namely (i) continuous power; (ii) power-on-demand; and (iii) 10 s transient power.

In the iBFC's continuous power mode, there is no net change in the state-of-charge (SoC) in the buffer meaning I_{buf}=0 and the charge transfer regulator's output relies solely on the fuel cell, i.e. I_{QXR}=I_{FC} where in one embodiment a m_{buf}=200 fuel cell is operated at a single current density [I_{FC}/A_{FC}]=200 mA/cm². In another embodiment, the QXR current limiter operates at two different current levels, [I_{FC}/A_{FC}]=200 mA/cm² in continuous mode and PoD mode, and double the current density [I_{FC}(10 s)/A_{FC}]=400 mA/cm² in 10 s transient mode.

It should be mentioned that when lithium-ion battery packs including the Tesla Powerwall refer to continuous current they mean the current other than short duration transient current. A battery's continuous current mode is only temporary so long that the batteries are charged. Once the battery is drain the pack is dead. By contrast, by converting hydrogen fuel into energy the buffered fuel cell described herein can truly operate continuously, i.e. perpetually, so long that fuel is available with no need for down time to recharge like a BEV or battery pack requires.

In power-on-demand (PoD) mode, the iBFC combines continuous power from the fuel cell stack and stored power from the buffer array. Like a battery pack. the iBFC buffer array contains a finite amount of charge Q_{buf} only able to supply current I_{buf}<0 to an electrical load for a limited amount of time until is completely discharged. In terms of the C-discharge rate, the maximum PoD interval is given by Δt_{buf}=1/CDR during which the current is I_{buf}=CDR(Q_{buf}). If however during a defined interval the buffer is alternatively charged and discharged, the available charge stored in the buffer is partially restored whereby Q_{buf}=Σ(I_{buf}/CCR−I_{buf}/CDR).

The charge stored in the buffer depends on the size of the buffer. In one string of Li-ion cells the charge per cell is Q_{buf}≡∫I_{buf} dt or in discrete form as Q_{buf}=ΣI_{buf}Δt_{buf}. Similarly in m_{buf} parallel strings of Li-ion cells the total charge capacity of the buffer array is Q_{buf}≡m_{buf}∫I_{buf} dt or in discrete form as Q_{buf}=m_{buf}ΣI_{buf}Δt_{buf} which means capacity in mAh scales with the number of parallel strings in the buffer array but not with the number of cells n_{buf} within a string. For example, a 6s1p array has a capacity of 3.2 Ah the same as a 2s1p array. A 6s3p array however holds 9.6 Ah, triple that of a 6s1p array.

In PoD mode the buffer array current adds to the fuel cell output based on the size of the buffer. As exemplified in the table below, in an iBFC comprising a 6s1p buffer array in a power-on-demand condition the buffer supplies 43 A while the buffer provide only 3 A for a total output to the load of 46 A. For a 6s3p buffer array in a power-on-demand condition the buffer supplies 43 A while the buffer provide 9.6 A for a total output to the load of approximately 53 A. In a 6s13p array, the fuel cell current and the buffer currents are roughly equal, with a total PoD output current of 85 A. Although the function of current source 5313a need to detect the load current I_{L} to calculate the current output I_{FC} from the fuel cell stack it cannot control the current flow from the buffer array 5314 to load 5204—only the BLA circuit 5303 can control the load current.

As another embodiment of this invention, during a 10 s transient QXR 5311a allows the current density of the fuel cell stack to double while BLA 5303 allows currents to flow in an aggregate amount equal to I_{FC} at A_{FC}(400 mA/cm²) plus a 10CDR buffer current I_{buf}=m_{buf}(I_{10C}). Referring again to the table, an iBFC with a 6s1p buffer array will conduct 86 A from the fuel cell array and 30 A from the buffer delivering a total output current of 116 A, roughly 2.7× its continuous output rating. An iBFC with a 6s3p buffer array will conduct 86 A from the fuel cell array and 96 A from the buffer delivering a total output current of 182 A, 4.2× its continuous output. An iBFC with a 6s13p buffer array will conduct 86 A from the fuel cell array and 416 A from the buffer delivering a total output current of 502 A, nearly 12 times its continuous output.

| | iBFC | Cont | Q_{buf} | PoD | 10 s Transient |
|---|---|---|---|---|---|
| Topology | Condition | (A) | (Ah) | Current (A) | Current (A) |
| FC Only | I_{FC} = I_{FC}(max), | 43 A | 0 | 43 A | 86 A |
| | m_{FC} = 200 | | | | |
| 6s1p | I_{1C} = 3.2 A, | | 3.2 | 43 A + | 86 A + |
| iBFC | I₁₀ₛ = 32 A | | | 3 A = 46 A | 32 A = 118 A |
| 6s3p | 3I_{1C} = 9.6 A, | | 10 | 43 A + | 86 A + |
| iBFC | 3I₁₀ₛ = 96 A | | | 10 = 53 A | 96 A = 182 A |
| 6s7p | 7I_{1C} = 22.4 A, | | 22 | 43 A + | 86 A + 224 |
| iBFC | 7I₁₀ₛ = 224 A | | | 22 A = 65 A | A = 310 A |
| 6s13p | 13I_{1C} = 41.6 A, | | 42 | 43 A + | 86 A + 416 |
| iBFC | 13I₁₀ₛ = 416 A | | | 42 A = 85 A | A = 502 A |
| 6s31p | 31I_{1C} = 100 A, | | 92 | 43 A + | 86 A + 1.0 |
| iBFC | 31I₁₀ₛ = 1000 A | | | 100 A = 143 A | kA = 1.09 A |
| 6s54p | 54I_{1C} = 173 A, | | 173 | 43 A + | 86 A + 1.6 |
| iBFC | 50I₁₀ₛ = 1730 A | | | 173 A = 216 A | kA = 1.69 kA |

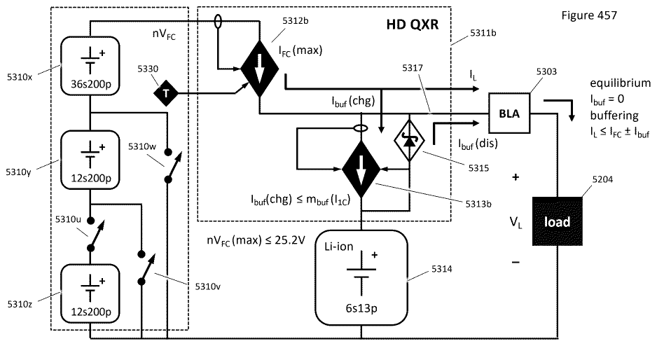

Another method to allow the fuel cell to deliver high load currents, i.e. heavy duty ‘HD’ operation, without damaging the buffer array involves a different charge transfer regulator circuit topology QXR 5311b as shown in FIG. 457. In this embodiment, the buffer current limiter 5313a which previously resided in the main I_{FC} current path is relocated between current summing node 5316 and the battery current limiter 5312. Beneficially by moving the modified current limiter 5313b out of the main I_{FC} current path between output node 5317 and buffer 5314, limiter 5313b can no longer interfere with the fuel cell directly supplying load 5204 with higher currents. Instead, the current output capability of fuel cell 5310 is limited only by the maximum fuel cell current without concern for protecting the buffer from adverse or excessive charging condition.

For example if the fuel cell stack is modified to contain μstacks with 12s250p membranes either by doubling the active area or by placing two 12s125p μstacks in parallel the current out from the fuel cell jumps to 54 A.

In its new location, buffer current limiter 5313b still protects buffer 5314 to a maximum charging current of 1 C. Its insertion between the output node and the buffer array however is problematic. In particular, the function of buffer current source 5313b is to unidirectionally charge the buffer array 5314 from the fuel cell and to protect the buffer from overcurrent conditions, whereby. current flowing from fuel cell 5310 into buffer 5314 is limited to 1 C per buffer string m_{buf}. As such, the size of the power DMOSFET used in charger current source is smaller than power MOSFETs used to power loads. As such, the current source 5313b is too resistive and too low in its current rating for supplying load transients at meaningful discharge rates of 2 C to 10 C. Moreover, its control circuit is not designed to accommodate or regulate reverse current flow.

In one embodiment, this problem is circumvented by introducing an antiparallel path around current regulator 5313b comprising power bypass circuit 5315 forming a new discharge path antiparallel to buffer current limiter. Unlike the current source 5313b, current limiter bypass circuit 5315 acts like a low-voltage-drop diode allowing current to flow from buffer 5314 to load 5317 but not in the opposite direction. For this reason, the device which is actually a power circuit is represented schematically as controlled Schottky rectifier.

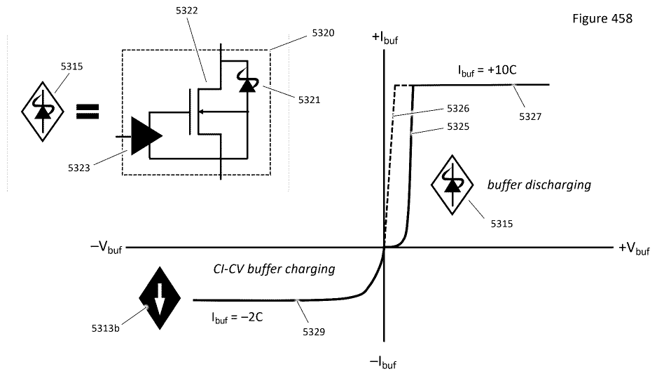

The bidirectional transfer characteristics between the output node 5317 and buffer 5314 are shown in the I-V graph of FIG. 458. In the negative polarity where current flows from the fuel cell 5310 into buffer 5314, the charging current is controlled by buffer current source 5312b to a safe value of −2 C per battery string depicted by curve 2329. The charging curve does not mean that a combination of voltage mode and current mode charging is not possible but only that the ‘maximum’ charging current is limited by current limiter 5313b to −2 C.

In the converse direction shown in quadrant I where positive discharge current flows out of buffer 5314 to the buffer load access protection and ultimately to load 5314, current limiter bypass ILB circuit 5315 according to diode curve 5325 then jumps to linear curve 5326 as soon as diode current is detected. The low drop is achieved by gate drive 5323 in bypass circuit 5320 turning on low resistance power MOSFET 5322 and shunting current around diode 5321. Bypass circuit 5320 circuit only allows current to flow unidirectionally from buffer 5314 to the output 5317 but not in the opposite polarity. As the current rises too high bypass circuit 5320 may current limit the discharge current to +10 C shown by curve 5327.

In this manner current flowing out of the fuel cell is limited only by its specified maximum current density [I_{FC}/A_{FC}], the buffer can participate in supplying current to a load from 2 C continuously and up to +10 C during transients all while the maximum charging current of buffer 5314 is limited to −1 C. Assuming a single buffer string of lithium ion batteries rated at 3500 mA, the maximum charging rate of the buffer is limited to 1 C or 3.2 A while the μstacks of fuel cells source 43 A of current, 3 A of which is used for recharging the buffer with 40 A remaining for powering the load. Once the buffer recharges the entire fuel cell output is available to the load as a steady state power limited only by cooling requirements. The steady state current capability of the iBFC without discharging the buffer is then 43 A at a nominal voltage Vₒᵤₜ=23.3V or 1000 W per μstack, again limited only by heat management.

In a high current transient a 6s1p buffer string comprising 3200 mA Li-ion cells, the transient discharge current limit for a single string of six 18650 lithium ion batteries is 32 A for up to 10 seconds. Adding that to 43 A from the fuel cell delivers a current of I_{load}=32 A+43 A=75 A. At a nominal voltage of 7.8V per μstack, each μstack delivers a continuous power of 333 W per μstack. For a fuel cell comprising only three μstack the total iBFC transient power out is 1000 W, i.e. 1 kW. If more power is required the circuitry can sense the high currents and increase the stack height by connecting more μstacks in series while limiting the voltage to under 40V.

### Measured PEM Membrane Losses.

The power output and power losses in every membrane is in order of priority a function of current density, relative humidity, and temperature. Aside from the fuel cell assembly and control circuitry described herein, process dependent membrane material properties, the subject of a significant portion of this application, have a profound influence on fuel cell operating efficiency. In order to build accurate electrical models of a fuel cell, the IEM voltage-current characteristics must first be verified. The primary source of characterization data is a membrane's polarization curves, a graph of the fuel cell voltage versus current or current density. When measure current is normalized to an active area A_{FC}=1 cm² then current in mA and current density in mA/cm are identical numerically.

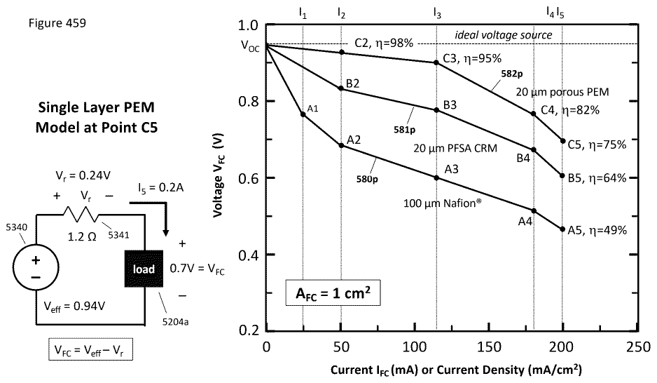

As shown in the polarization curves of FIG. 459 the measured output voltage of three different fabricated membranes privately fabricated in association with this invention are contrasted highlighting several inflection points. Although all three membranes show a decline in output voltage V_{FC} with increasing current I_{FC}, a electrical characteristic common for PEM membranes, the 100 μm thick conventional Nafion® film curve 580p shows the most degradation with increasing current. As shown curve 580p demonstrates a rapid drop then a slope change at point A1 for currents I_{FC}≤I₁=25 mA/cm² and a second slope change at point A2 corresponding to current I_{FC}≥12=50 mA/cm². This region referred to as the ‘activation loss’ region is largely explained by the activation energy required for electrochemical reactions and electrode reaction kinetics.

A second region, known as the ‘ohmic loss' region at moderate current densities between points A2 and A4, As a straight line on an V-I curve the region can be characterized as a small signal series linear resistance R═∂V_{FC}/∂I_{FC} over the region spanning the range from I₂=50 mA/cm² and I₄=σ180 mA/cm². Due to its linearity, the phenomena is primarily attributed to resistance to the flow of ions through the membrane and to a lesser extent to electronic conduction losses through the electrodes and external circuit. As described previously in the section on charge transport, the ohmic region includes Joule heating and kinetic losses due to the imperfect processes of proton capture and release affecting diffusivity, and by inelastic collisions of protons affecting carrier mobility. Although there is a slight change in slope in Nafion® polarization curve 580p at point A3 it is relatively minor. Beyond current density I₄>180 cm² identified the span from point A4 to A5, voltage losses sharply increase identifying the onset of the concentration loss region. Conduction losses in this region are generally attributed to voltage drop due to mass transport limitations, where the reactants are not supplied to the electrodes quickly enough and to parasitic effects such as water logging, swelling, and fluid retentions interfering with charge transport.

By contrast the experimentally fabricated film comprising a 20 μm thick PFSA composite reinforced membrane shown by curve 581p demonstrates significantly lower voltage sag at point B2 and lower series resistance between B2, B3, and B4. These beneficial characteristics in the ohmic region are attributable to reduced scattering from enhanced crystallinity from the PTFE polymeric backbones offset by a lower effective ionomeric cross section where inert PTFE polymers displace conducting PFSA segments. Above current Is shown by point B5. high current effects begin to dominate losses leading to significant voltage sag and large thermal losses.

Significant improvements in fuel cell efficiency are demonstrated by the 20 μm microporous membrane made in accordance with this invention. As shown by curve 582p, the enhanced transport in the film all but eliminates activation losses between points 0 and C2 retaining an efficiency of η=0.92V/0.94V=98% which declines to η=0.89V/0.94V=95% remaining relatively flat with a small constant differential resistance of ∂V_{FC}/∂I_{FC}=(0.94V−0.89V)/(110 mA)=0.5Ω until point C3. Beyond current I₃=110 mA/cm² differential ohmic losses increase, but the membrane retains an overall efficiency of η=0.77V/0.94V=82%. At point C5 corresponding to I_{FC}/A_{FC}=200 mA/cm², the efficiency further declines to η=0.70V/0.94V=75%.

At this current the average resistance of the fuel cell is approximately given by R=(0.94V−0.70V)/(200 mA)=240 mV/200 mA=1.2Ω. As shown, an equivalent electrical model of the fuel cell operating at point C5 at 200 mA is a voltage source 5240 with an effective voltage V_{eff}=0.94V and a 1.2Ω series resistance 5341. With a voltage drop of Vᵣ=0.24V across resistor 5341, the measured fuel cell voltage V_{FC}=V_{eff}−Vᵣ=0.94V−0.24V=0.70V present at the fuel cell output and across electrical load 5204a. Comparing the η=75% efficiency of the porous membrane at point C5 to the other measured curves illustrates the substantial benefits of the disclosed PEM membrane mad in accordance with this invention. Specifically point B5 for the PFSA CRM membrane has an efficiency of η=0.60V/0.94V=64%, a full 11% less efficient than the porous PEM membrane. The effective resistance of the composite PFSA film is R=(0.94V−0.60V)/200 mA=340 mV/200 mA=1.70, a 42% higher series resistance. The performance of commercial Nafion® at point A5 is even worse with an efficiency of η=0.46V/0.94V=49% with a resistance R=(0.94V−0.46V)/200 mA=480 mV/200 mA=2.4Ω, double the resistance of the porous membrane of point C5.

The single-layer unit-area (1s1p) PEM electrical model derived from measured data can be linearly scaled from n_{FC}=1 and m_{FC}=1 to other dimensions to confirm the electrical performance of a wide variety of fuel cell voltages, currents, power levels, and applications. Moreover, further studies have shown that by thinning the gas diffusion layers only slightly lowering parasitic resistances in the MEA5, the ohmic resistance of the 1s1p model can be further reduced by 20% or more with no impact on the electrochemical effective voltage V_{eff} of the cell. As such, the reference model is adjusted by changing the ohmic resistance to R_{FC}=1.0Ω.

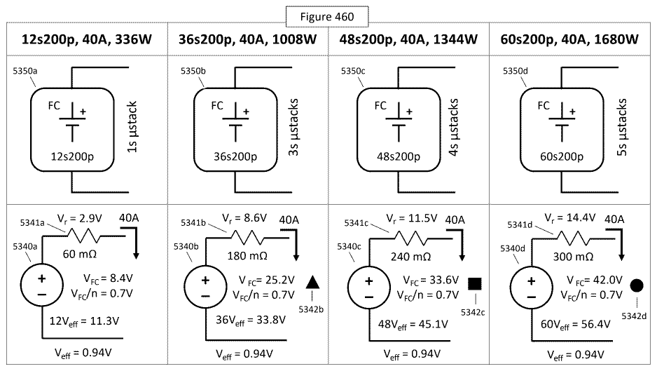

As shown in FIG. 460, these scaled models include (n_{FC})s(m_{FC})p=12s200p, 36s200p, 48s200p, and 60s200p. For example, in 12s200p μstack fuel cell 5350a, a n_{FC}=12 layer fuel cell with an active area of m_{FC}[A_{FC}′]=200 cm² has a circuit model as shown comprising voltage source 5340a with an single layer effective voltage V_{eff}=0.94V or a twelve-layer voltage of 12V_{FC}=12(0.7V)=8.4V and a corresponding series resistance of R═[R_{FC}′](n_{FC}/m_{FC})=(1.0Ω)(12/200)=60 mΩ. Note the terms with a prime symbol [A_{FC}′]≡1 and [R_{FC}′]=1Ω refer to a unit cell reference model used to predict the behavior larger fuel cells or arrays of μstack fuel cells.

Given an area of A_{FC}=200 cm² and a current density of [I_{FC}/A_{FC}]=200 mA/cm² consistent with measured values, the 12s200p μstack fuel cell 5350a has a current of I_{FC}=40 A and by Ohm's law, a voltage drop Vᵣ=(40 A)(60 mΩ)=2.9V across resistor 5341a. The terminal voltage of the μstack fuel cell is then V_{FC}=V_{eff}−I_{FC}R_{FC} which at I_{FC}=40 A becomes V_{FC}=11.3V−2.9V=8.4V with a corresponding efficiency η=8.4V/11.3V≈75% and per layer voltage V_{FC}/n_{FC}=8.4V/12=0.7V per layer. In other words a standard reference model for a 12s200p μstack array based on measured data and a linearly scalable MEA7 model comprises a 0.94V voltage source and a 1Ω series resistance producing a terminal voltage of 8.V at 40 A load current for a net generated power output of 336 W at an efficiency of 75%. By stacking the models in series, higher voltages and power levels can be produced without reengineering the μstack.

The waste heat generated in each 12-layer μstack module is therefore Pₗₒₛₛ=(25%)(336 W)=84 W thermally cooled over two 200 cm² surfaces at a wort-case power density of 0.4 W/cm² comprising thermal conduction into conductive backplane and forced air convection off its surface. Assuming a worst case temperature rise to T_{FC}=85° C., the temperature differential to a backplane at T_{bp}=25° C. is ΔT=T_{FC}−T_{bp}=60° C. with a corresponding thermal impedance of θ_{μs}=ΔT/P=60° C./85° C.=0.70° C./W. Such thermal impedance can be achieved convectively by air cooling at a flow rate of 0.02 cm³/s not including conductive cooling into the backplane. Because each μstack maintains its own thermal equilibrium to the PCB and to the air, combining μstacks to achieve higher power levels is not thermally limited. In this way, the μstacks can be series connected to achieve higher power output levels using the reference model to predict their performance.

In one embodiment a 36s200p fuel cell array 5350b comprises three series μstacks with a V_{eff}=33.8V effective voltage, a 180 mΩ resistance, an output voltage of 25.2V, a 40 A output current delivering a power output of 1006 W at η≈75%. In essence every three 12-layer μstacks deliver 1 kW of output power. In a second embodiment a 48s200p fuel cell array 5350c comprises four series μstacks with a V_{eff}=45.1V effective voltage, a 240 mΩ resistance, an output voltage of 33.6V at 40 A delivering a power output of 1344 W at η≈75%. In a third embodiment a 60s200p fuel cell array 5350d comprises five series μstacks with a V_{eff}=56.4V effective voltage, a 300 mΩ resistance, an output voltage of 42V at 40 A output current delivering a power output of 1680 W at η≈75%. These μstacks performance specifications are summarized in the following table for ease of comparison:

| Parameter | Calculation | μstack Configuration | | | | | | | | | |
|---|---|---|---|---|---|---|---|---|---|---|---|
| Topology | (n_{FC})s(m_{FC})p | 12s200p | | 24s200p | | 36s200p | | 48s200p | | 60s200p | |
| # of μstacks | (n_{FC})(m_{FC})/2400 | 1 | | 2 | | 3 | | 4 | | 5 | |
| Current I_{FC} | m_{FC}(200 mA/cm²) | 40 | A | 40 | A | 40 | A | 40 | A | 40 | A |
| Effective V_{eff} | n_{FC}(0.94 V) | 11.3 | V | 22.6 | V | 25.2 | V | 45.1 | V | 56.4 | V |
| Resistance R_{FC} | n_{FC}(5 mΩ) | 60 | mΩ | 120 | mΩ | 180 | mΩ | 240 | mΩ | 300 | mΩ |
| Output V_{FC} | V_{eff} − I_{FC}R_{FC} | 8.4 | V | 17.8 | V | 25.2 | V | 33.6 | V | 42.0 | V |
| Power P_{FC} | I_{FC}V_{FC} | 336 | W | 712 | W | 1008 | W | 1344 | W | 1680 | W |

| | | | | | | |
|---|---|---|---|---|---|---|
| Efficiency η | P_{FC}/(V_{eff} I_{FC}) | 75% | 75% | 75% | 75% | 75% |

| | | | | |
|---|---|---|---|---|
| Heat Pₗₒₛₛ | (1 − η)P_{FC} | 83 | W | — |

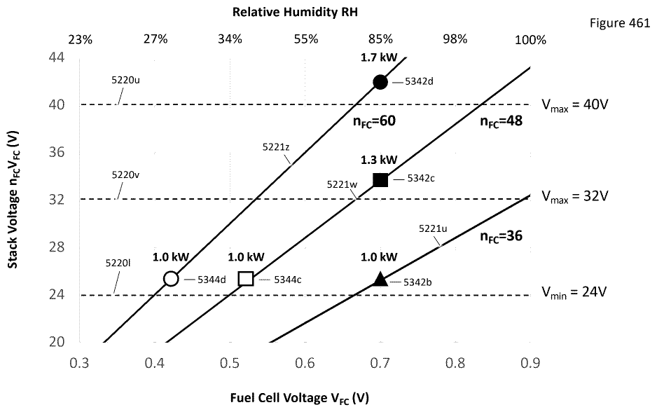

FIG. 461 illustrates the dependence of the fuel cell stack voltage n_{FC}V_{FC} as a function of the single-layer fuel cell voltage V_{FC} as denoted on the lower x-axis or by the relatively humidity RH labelled on the upper x-axis. The relationship is shown for three cases comprising n_{FC}=36 shown by line 5221u, n_{FC}=48 shown by line 5221w, and n_{FC}=60 shown by line 5221z. The specific electrical characteristics for three, four, and five μstack configurations at are overlaid onto the graph by the corresponding markers 5432b, 5432c, and 5432d respectively at a condition where V_{FC}=0.7V per layer. The curves illustrate the stack voltage n_{FC}V_{FC} increases linearly with an increased number of cells.

Looking at the maximum voltage of the stack, the 36-layer stack voltage 5221u does not exceed a 32V maximum voltage 5220w over the entire range of fuel cell voltages and humidity levels. The 36-layer design does however drop below the 24V minimum allowed voltage 5220l at V_{FC}=0.67V per layer corresponding to a RH=74%. For n_{FC}=48 curve 5221w, the voltage exceeds a 40V maximum stack voltage criteria 5220u around a humidity 98.5% when V_{FC}=0.83V per layer. It also drops below the 24V minimum allowed voltage 5220l at V_{FC}=0.5V per layer corresponding to a RH=34%. The voltage curve 5221z for the n_{FC}=60 layer design exceeds a 40V maximum stack voltage criteria 5220u when V_{FC}=0.67V per layer at a humidity of 74 and drops below the 24V minimum allowed voltage 5220l at V_{FC}=0.4V per layer corresponding to a RH=27%.

So in essence the high layer count stacks function to lower humidity levels at cell voltages but easily exceed the maximum voltage within a normal humidity range of 85%. Conversely stacks of fewer cells do not exceed the maximum target voltage but fail to produce adequate voltage below RH=74%. In essence, no one curve satisfies the target stack voltage range over a nominal humidity range. All three fuel cell stack designs are able to satisfy the need for producing a 1 kW output at 25V, well above the 24V minimum voltage 5220l.

These three cases are shown by point 5432b for a n_{FC}=36 for V_{FC}=0.7V and RH=85%; by point 5432c for a n_{FC}=48 for V_{FC}=0.52V and RH=36%; and by point 5432d for a n_{FC}=60 for V_{FC}=0.42V and RH=29%. As shown in FIG. 462 they include the reference 36s200p array 3560p with voltage 5350p at V_{eff}=0.94V or n_{FC}V_{eff}=33.8V, resistance 5341p at R═180 mΩ, and an output at 40 A of V_{FC}=0.7V per layer or n_{FC}V_{FC}=25.2V total delivering 1008 W. By contrast the taller 48p200q stack 5350w can deliver 1 kW at lower voltages corresponding to lower humidity levels, specifically where voltage source 5340q has a lower effective voltage V_{eff}=0.76V but a higher effective stack voltage n_{FC}V_{eff}=36.7V. Subtracting the voltage present across 240 mΩ resistor 5341q the fuel cell stack output voltage remains constant at n_{FC}V_{FC}=25.2V corresponding to V_{FC}=0.53V per layer. In essence by increasing the number of μstacks from 3 to 4, the minimum per layer output voltage drops from 0.7V to 0.53V.

As shown by 60s200p fuel cell stack 5350r, the fuel cell voltage is able to function down to V_{eff}=0.66V by increasing the number of layers from n_{FC}=48 to n_{FC}=60 and correspondingly increasing the effective stack voltage 5340r to n_{FC}V_{eff}=39.6V. This higher voltage offsets the losses in resistance 5341r which increases from 240 mΩ to 300 mΩ. The resulting output voltage remains unchanged at n_{FC}V_{FC}=25.2V but corresponds to a lower V_{FC}=0.66V per layer. In this manner switching among various numbers of μstacks enables a guaranteed 1 kW output despite declining cells voltages in low humidity conditions.

Once adverse effect of including more fuel cells into a stack, is the added ohmic losses which decrease the overall efficiency when the cells are running at lower voltages. For example while the three μstack design operates at 75% efficiency, four μstacks drop to η=25.2V/36.7V=68%. This is still significantly better than conventional fuel cells that cant operate at all without humidification which consumes power and lowers the overall system efficiency even more.

### Effective Power Output.

The iBFC output current described previously for continuous, PoD, and transient modes can be translated into output power by the formula Pₒᵤₜ=(Iₒᵤₜ)(Vₒᵤₜ). In continuous conduction mode, with V_{BFC}=23.3V and I_{BFC}=43 A, the power output of the buffered fuel cell is 1 kW.

In power-on-demand conditions, iBFC designs with buffers ranging from 6 Li-ion (6s1p) cells to 318 (6s53p) cells, the PoD outputs range from 1.1 kW to 5.0 kW. Of particular interest is the 6s31p iBFC where combining with three 200 cm² fuel cells with 186 Li-ion cells results in 3.3 kW of generated output, 1 kW of which is generated from fuel, the other two-thirds from buffer-stored charge. The series or parallel connection of six 6s31p iBFC produces a 10 kW power-on-demand system comprising 3 kW of continuous power and 7 kW of buffer power.

Alternatively, series or parallel connection of two 6s53p iBFC produces a 10 kW power-on-demand system comprising 2 kW of continuous power and 8 kW of buffer power. Because of the different ratio of buffer stored power to fuel cell generated power the two 5 kW modules require 106 Li-ion cells while three 3333 W modules require only 93 Li-ion cells.

| Buffer | Voltage | Cont | Cont | PoD | | PoD | | 10 s Trans | | 10 s Trans | |
|---|---|---|---|---|---|---|---|---|---|---|---|
| Topology | V_{BFC} (V) | I_{BFC} (A) | P_{BFC} (W) | I_{BFC} (A) | | P_{BFC} (W) | | I_{BFC} (A) | | P_{BFC} (W) | |
| 0s0p FC only | 23.3 V | 43 A | 1.0 kW | 43 | A | 1.0 | kW | 80 | A | 1.8 | kW |
| 6s1p iBFC | n_{FC} = 36 | 215 mA/cm² | 3 μstacks | 46 | A | 1.1 | kW | 120 | A | 2.8 | kW |
| 6s3p iBFC | | m_{FC} = 200 | | 53 | A | 1.2 | kW | 180 | A | 4.1 | kW |
| 6s7p iBFC | | | | 65 | A | 1.5 | kW | 300 | A | 6.9 | kW |
| 6s13p iBFC | | | | 85 | A | 2.0 | kW | 500 | A | 12 | kW |
| 6s31p iBFC | | | | 143 | A | 3.333 | kW | 1 | kA | 23 | kW |
| 6s53p iBFC | | | | 216 | A | 5.0 | kW | 1.7 | kA | 38 | kW |

The calculation of the 10-second transient power assumes a doubling of fuel cell generated current at [I_{FC}(PoD)/A_{FC}]=2(215 mA/cm²)=(430 mA/cm²) along with a discharge rate of CDR=10 C for the buffer cells where I_{10C}=10(3.2 A)=32 A. Transient power is only an approximation as variations in current densities, self heating in conduction, stray inductance, PCB capacitance, and parasitic resistance collectively affect the peak current and transient waveforms.

As such, excess precision in the calculations are unnecessary. For example for the 6s31p iBFC design, the I_{FC}(10 s)=(200 cm²)[430 mA/cm²]≈2(43 A)≈86 A. The transient buffer current I_{buf}(10 s)=m_{buf}(I_{10C})≈31(32 A)≈992 A which combined with the 86 A fuel cell current equals the summation I_{BFC}(10 s)=I_{FC}(10 s)+I_{buf}(10 s)=86 A+992 A=1078 A≈1 kA with a corresponding transient power of P_{BFC}(10 s)=V_{buf}(I_{FC}(10 s)+I_{buf}(10 s))≈(23.3V)(1 kA)≈23 kW. Transient power is only meaningful to ensure there is sufficient momentary power needed to supply capacitive inrush power and motor cold cranking current needed to overcome stiction.

The below table is an exemplary comparison of iBFCs capable of 5 kW power-on-demand comprising 12-layer μstacks, each with an area of A_{FC}=200 cm². The topology of the fuel cell there for is given as (n_{FC})s(m_{FC})p where n_{FC} equals the total number of fuel cell layers in integer multiples of twelve, i.e. 12, 24, 36, 48, 60, 72, and 84; and where m_{FC} is the dimensionless ratio of the total area of all fuel cell layers connected in parallel divided by a unit area of 1 cm². In this example m_{FC} is limited to integer multiples of 200, i.e. m_{FC}=200, 400, 600 for one, two, or three parallel cells of 200 cm² each. Calculations to complete the following table involve the following steps:
FC #—The total number of μstack fuel cells FC # in an array (n_{FC})s(m_{FC})p comprises the integer multiple of fuel cell μstacks irrespective of their topological arrangement FC #=int{(n_{FC}/12)(m_{FC}/200)}=int{(n_{FC})(m_{FC})/2400}. For example for a 48s200p the FC #=int{(48/12)(200/200)}=4 μstacks. For a 36s400p the FC #=int{(36/12)(400/200)}=int{(3)(2)}=6 μstacks.
V_{BFC}—The output voltage V_{BFC} of the buffered fuel cell in this example is given by the total number of series connected fuel cell layers n_{FC} multiplied by the minimum per-layer fuel cell voltage V_{FC}=0.65V when I_{buf}=0, i.e. when the buffer is charged to the same voltage as the fuel cell stack, mathematically as V_{BFC}=n_{FC}V_{FC}=n_{FC}(0.65V).
I_{FC}—The total fuel cell output current during normal operation, i.e. not in 10 s transient mode, is given by number of parallel-connected fuel cell layers expressed by the dimensionless factor m_{FC} multiplied by the nominal current density [I_{FC}/A_{FC}]=215 mA/cm², or algebraically as I_{FC}=(A_{FC})[I_{FC}/A_{FC}]=(m_{FC}·1 cm²)[I_{FC}/A_{FC}]=(m_{FC})(215 mA).
Buf #—The total number of buffer cells in a buffer array (n_{buf})s(m_{buf})p irrespective of the topological configuration is given by the multiplicative product of its number of buffer cells in each string n_{buf} multiplied by the number of parallel strings m_{FC} whereby Buf #=(n_{buf})(m_{buf}).
I_{buf}—The buffer current I_{buf} during power-on-demand (PoD) mode is equal to the C-discharge rate CDR times the buffer charge Q_{buf} whereby I_{buf}=(m_{buf})(CDR)(Q_{buf}) and where for a Li-ion 18650 cell Q_{buf}=3.2 Ah. For a CDR=1 C, the I_{buf}=m_{buf}(3.2 A). In one examples a 8s37p buffer array comprising 297 cells discharging at 1 C carries I_{buf}=m_{buf}(3.2 A)=(37)(3.2 A)=118 A while a 12s20p array of 240 cell array has a 1 C discharge rate of I_{buf}=m_{buf}(3.2 A)=(20)(3.2 A)=64 A in PoD mode and a I₁₀ₛ=m_{buf}(I_{10C})=(20)(32 A)=640 A in 10 s transient mode. In steady-state, aka continuous mode where the buffer does not change its state-of-charge, I_{buf}=0.
Iₛₛ—The steady state or continuous current output from the iBFC to the load is entirely supplied by the fuel cell, i.e. I_{SS}=I_{FC}. As illustrated in the table when I_{FC}=43 A, them I_{SS}=43 A, when I_{FC}=86 A, them I_{SS}=86 A.
Pₛₛ—The steady state power is given by the buffer fuel cell output voltage VBFC times the steady state current, whereby P_{SS}=(V_{BFC})(I_{SS}). Examples include 48s200p fuel cell delivering 43 A for 1.3 kW continuous power; 36s400p delivering 86 A for 2 kW; and 60s400p delivering 86 A for 3.3 kW of continuous power
Power-on-Demand—For power-on-demand conditions where I_{PoD}=I_{FC}+I_{buf} current is supplied by both the fuel cell and the buffer so long that Q_{buf}>0. For example, in the fuel cell topology 36s200p, the iBFC delivers 215 A at 23.3V for a power output of 5 kW, where 80% of the PoD power comes from the buffer, and only 20% from 3 fuel cell μstacks. In the fuel cell 36s400p, the iBFC delivers 215 A at 23.3V for a power output also comprising 5 kW, where 60% of the PoD power comes from the buffer, and 40% its 6 fuel cell μstacks. In another iBFC design with a 5 kW power output, increasing the fuel cell contribution to 9 μstacks with a 36s600p topology delivers 215 A at 23.3V where 40% of the PoD power comes from the buffer and 60% from the fuel cell electrical generation.

The following table illustrates the flexibility of the iBFC is reconfiguring the overall charge generation and storage capability of the iBFC for varying designs. For convenience, the fuel cell topologies shown are multiples of 12-layers to match without limitation the aforementioned exemplary μstacks.

| # | FC | Voltage | FC | | Buffer | Buffer | | | | Cont | PoD | | PoD |
|---|---|---|---|---|---|---|---|---|---|---|---|---|---|
| FC | Topology | V_{BFC} (V) | I_{FC} (A) | | Topology (#) | I_{buf} (A) | | Cont | | Pₛₛ (W) | I_{PoD} (A) | | P_{PoD} (W) |
| =int{(n_{FC}) | | =(n_{FC}) | =(m_{FC}) | | #buf = int | =(m_{buf}) | | Iₛₛ (A) | | =(I_{FC}) | =I_{FC} + | | =(I_{PoD}) |
| (m_{FC})/2400} | | (0.65 V) | (0.215 A) | | {(n_{buf})(m_{buf})} | (3.2 A) | | =I_{FC} | | (V_{BFC}) | I_{buf} | | (V_{BFC}) |
| 3 | 36s200p | 23.3 V | 43 | A | 6s54p (324) | 172 | A | 43 | A | 1.0 kW | 215 | A | 5.0 kW |
| 4 | 48s200p | 31.2 V | 43 | A | 8s37p (296) | 118 | A | 43 | A | 1.3 kW | 161 | A | |
| 5 | 60s200p | 39.0 V | 43 | A | 10s27p (270) | 85 | A | 43 | A | 1.7 kW | 128 | A | |
| 6 | 36s400p | 23.3 V | 86 | A | 6s40p (240) | 129 | A | 86 | A | 2.0 kW | 215 | A | |
| 6 | 72s200p | 46.6 V | 43 | A | 12s20p (240) | 64 | A | 43 | A | 2.0 kW | 107 | A | |
| 7 | 84s200p | 54.6 V | 43 | A | 14s15p (210) | 49 | A | 43 | A | 2.4 kW | 92 | A | |
| 9 | 36s600p | 23.3 V | 129 | A | 6s27p (162) | 86 | A | 129 | A | 3.0 kW | 215 | A | |
| 10 | 60s400p | 39.0 V | 86 | A | 10s13p (130) | 42 | A | 86 | A | 3.3 kW | 128 | A | |

As an embodiment of this invention, the iBFC facilitates a spectrum of designs to deliver power-on-demand whereby the share of deliverable power can be allocated by design in any ratio between the continuous steady-state generating capability of μstack fuel cells and the rapid low impedance deliver of the electrochemical buffer array.

Unlike in a battery buffer where increasing the energy capacity of the battery pack necessarily results in an equivalent increase in output power, i.e. where (E_{bat})/(P_{bat})=constant, in the buffered fuel cell the power-on-demand output capability in kW can be adjusted independently from the stored energy kWh. For example, a high-capacity iBFC doesn't require a large buffer for storing charge, hydrogen fuel provides that benefit. Similarly a high power output can be achieved with a high capacity high Q_{buf} buffer array, a large fuel array high current fuel cell, or some combination thereof even if the stored fuel capacity is minimal.

The iBFC architecture made in accordance with this invention is also scalable to different power levels either by modifying the buffer-to-fuel-cell current ratios or by paralleling or stacking modules. For example, the parallel combination of two 24V 5 kW iBFC modules results in a 10 kW 24V module with twice the current delivery capability of the individual modules, increasing the current output from 210 A to 420 A. The series stacking of two 24V 5 kW iBFC modules results in a 10 kW module capable of delivering 210 A at 48V.

Both current and voltage output specifications are independent of the kWh energy capability of the system which depends only on its hydrogen fuel. Regardless of the size of the fuel cell, each kilogram is capable delivers 33 kWh of energy. Considering a head-to-head comparison of battery packs to the buffered fuel cell, and 11 kW rated battery module can deliver roughly 11 kWh of energy, meaning to match the capability of the iBFC with 1 k of hydrogen requires three battery pack modules, just to handle one day's home use. Even a diminutive 1.4 kW fuel cell can convert and deliver one days worth of energy, i.e. 33 kWh to a home without exceeding its energy delivery capacity.

Scaling a 5 kW iBFC to a higher power such as 10 kW made in accordance with this invention involves three possible solutions (i) increasing the percentage of power delivered from the fuel cell; (ii) connecting two 5 kW modules in which case the ratable power contributions remain unaltered, or (iii) increasing the fractional contribution of buffer power.

| # | FC | Voltage | FC | Buffer | | | Cont | PoD | PoD |
|---|---|---|---|---|---|---|---|---|---|
| FC | Topology | V_{BFC} (V) | I_{FC} (A) | Topology (#) | Buffer | Cont | Pₛₛ (W) | I_{PoD} (A) | P_{PoD} (W) |
| =int{(n_{FC}) | | =(n_{FC}) | =(m_{FC}) | #buf = int | I_{buf} (A) | Iₛₛ (A) | =(I_{FC}) | =I_{FC} + | =(I_{PoD}) |
| (m_{FC})/2400} | | (0.65 V) | (0.215 A) | {(n_{buf})(m_{buf})} | =(m_{buf})(3.2 A) | =I_{FC} | (V_{BFC}) | I_{buf} | (V_{BFC}) |
| 4 | 48s200p | 31.2 V | 43 A | 8s87p (696) | 277 A | 43 A | 1.3 kW | 320 A | 10 kW |
| 5 | 60s200p | 39.0 V | 43 A | 10s67p (670) | 213 A | 43 A | 1.7 kW | 256 A | |
| 6 | 36s400p | 23.3 V | 86 A | 6s108p (648) | 344 A | 86 A | 2.0 kW | 430 A | |
| 6 | 72s200p | 46.6 V | 43 A | 12s54p (648) | 172 A | 43 A | 2.0 kW | 215 A | |
| 7 | 84s200p | 54.6 V | 43 A | 14s44p (616) | 140 A | 43 A | 2.4 kW | 183 A | |
| 8 | 96s200p | 62.4 V | 43 A | 16s37p (592) | 117 A | 43 A | 2.7 kW | 160 A | |
| 8 | 48s400p | 31.2 V | 86 A | 8s73p (584) | 235 A | 86 A | 2.7 kW | 321 A | |
| 10 | 60s400p | 39.0 V | 86 A | 10s53p (530) | 170 A | 86 A | 3.4 kW | 256 A | |

The above table reveals the a 10 kW iBFC as shown comprising four-to-ten 20 cm² twelve-layer μstacks may deliver between 1.3 kW (13%) to 3.4 kW (34%) of its output power from electric generation within the fuel cell. To reach 50% generated power, i.e. 5 kW of 10 kW out requires 15 μstacks where every three μstacks produce 1 kW.

iBFC Power Blade. Although the iBFC can be arrayed to form 2 kW, 5 kW, 10 kW and even 20 kW energy modules using the methods detailed herein, in an alternative embodiment the iBFC can be configured as 5 kW power blades.

In a computer blade server, pluggable printed circuit boards (PCBs) called server blades contain arrays of processors and highs peed memory used for high speed computing, artificial intelligence, cloud services, bitcoin and crypto mining, communication networking, and other scalable computing functions. The PCBs are plugged into an enclosure called a rack, frame, or cage, where the connectors, aka backplane, provide the electrical connections into and out of the PCB to the outside world including power to drive the processors and high speed memory, power to any onboard cooling. The connectors also include high speed data busses, control busses, Ethernet, or standardized computer bus interfaces. Collectively, these cages power server blades while facilitating external connectivity. The cage also provides local cooling to a server farm's all important HVAC cooling system, without which the servers would burn up.

While in a server farm each card represents an electrical load, in an set of inventive embodiments of the intelligent buffered fuel cell described herein a new class of rack-mounted modules contains power generating circuitry and energy storage capacity. Referred to herein as iBFC power blades, these power generating modules form a modular scalable power source for residential and commercial buildings and offices, as well as backup power for hospitals and mission critical use cases.

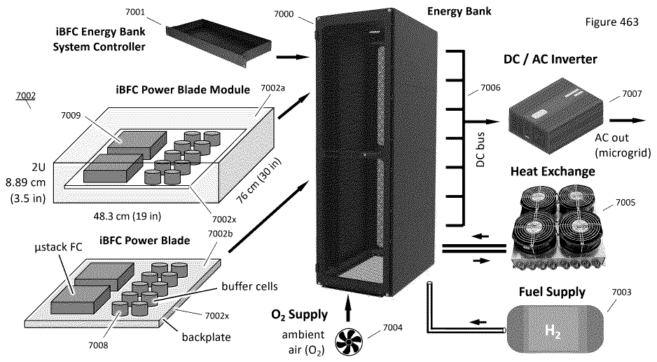

As depicted in FIG. 463, iBFC power blades 7002 either as open-frame iBFC power blades 7002a or enclosed iBFC power blade modules 7002b, comprise an assemblage of μstack fuel cells 7009 and arrays of buffer cells 7008 mounted on specially designed backplates 7002x. When plugged into rack mounted cage referred to herein as energy bank 7000, the combination of power blades 7002 and other components form an integrated power generation system with outputs ranging from 5 kW to 100 kW per cage depending on the number of operating blades. By inserting the power blades into compatible slots in the energy bank 7000, under coordinated control of system controller 7001 the energy bank
provides electrical connectivity among the power blades 7002 via DC bus 7006;
delivers fuel cell reactants of hydrogen 7003 to every power blade 7002 and the μstack fuel cells 7009 powering them;
provides oxygen or air 7004 to every power blade 7002 and the μstack fuel cells 7009 powering them;
facilitates direct electrical charging of buffer cells 7008 in power blades 7002 from an external electrical power source such as PV solar power, wind generators, diesel backup generators, or from grid power;
provides temperature regulation and cooling via a shared heat exchange unit 7005.

Power generated by fuel cell μstacks 7009 and stored in arrays of buffer cells 7008 contained in each power blade is summed together in DC power bus 7006 then delivered to DC-to-AC inverter 7007, the power output of which is distributed to users and electrical loads via an AC microgrid. In this manner, any group of persons, businesses, or neighborhoods can operate their own private electrical utility grid, converting hydrogen into electricity and distributing the generated power to its owners and users by way of a shared microgrid.

In the example shown, backplates 7002x have dimensions matched to the card slots, specifically a width of 76 cm (30 in) and a depth of 48.3 cm (19 in). Because of the height of lithium ion buffer cells used in the IBFC, comprising for example 18650 canisters, the power blade height is rated as 2 U, i.e. having a maximum dimension of 8.89 cm (3.5 cm).

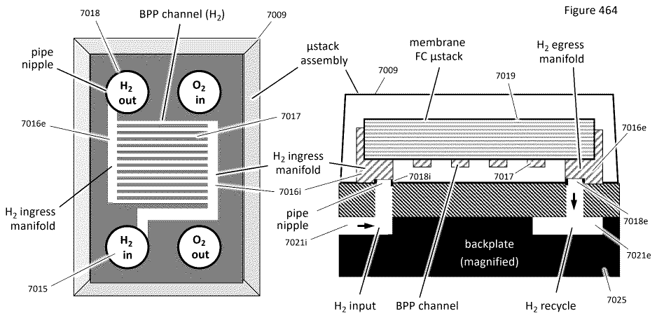

As shown in FIG. 464, the energy bank 7000 employs tubeless gas delivery from hydrogen 7003 and oxygen 7004 sources to the fuel cell μstack 7019 where the redox reactants are converted into electricity for contemporaneous use or stored electrically for subsequent use and on-demand power. In one embodiment, the hydrogen and oxygen reactants are routed from their supply sources into and along the back of the cage, through the blade sockets and into the individual power blade backplates 7025. Specifically hydrogen is conducted through gas conduit 7021i within backplate 7025 and through pipe nipple 7018i into the hydrogen ingress manifold 7016i within μstack fuel cell assembly 7009. The hydrogen gas fuel then flows through channels 7017 located within the fuel cells' bipolar plates, with portions converted by the fuel cells and transported across membrane 7019 to the fuel cells' cathodes. For clarity's sake the hydrogen anode flow circuit is illustrated but the oxygen cathode circuit has been exclude, the structure of which mirrors the anode except that oxygen instead of hydrogen is supplied and water removal from its effluent gas is a more significant issue.

Returning to the FC anode, hydrogen flowing into the fuel cell and being distributed by the hydrogen ingress manifold 7016i then flows across the face of the IEM membrane μstack 2019 through BPP channels 7017. Excess unconverted hydrogen not transported through the membranes is collected by the hydrogen egress manifold 7016e for recycling, whereby unused gas exits μstack assembly 7009 through pipe nipple 7018e and into H₂ recycle conduit 7021e within backplate 7025. The returned hydrogen gas then flows back to a central system where optionally the moisture is adjusted, i.e. regulated within a target range of relative humidity. Once processed the recycled hydrogen is returned to the hydrogen input network thereby forming a closed-loop hydrogen circuit where no unionized hydrogen gas is wasted or vented into the air.

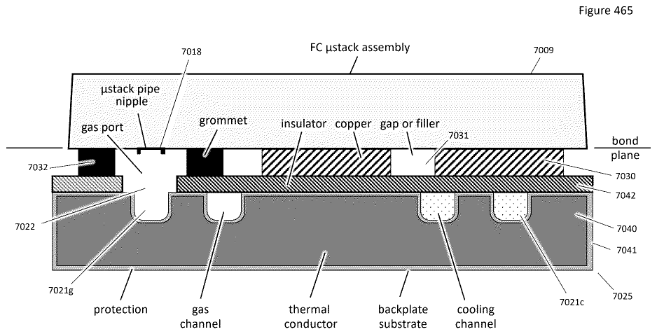

In another embodiment of the invention, gas is delivered into the fuel cell μstack module without the use of flexible tubing, but instead by directly attaching fuel cell μstack assembly 7009 onto the backplate 7025 as shown in FIG. 465. As shown, backplate 7025 includes a thermally conductive core 7040 comprising a metal, carbon, or combinations thereof protected from corrosion by a thin coating or anodized layer 7041.

Within the core of backplate 7025, a number of gas and coolant channels, 7021g and 7021c respectively are embedded to transport gases and vapor through the backplate to the various μstack fuel cells 7009. By distributing gasses within backplate 7025 the need for flexible tubes and hoses which invariable age and suffer leakage over time can be eliminated. The inventive embodiments herein distinguishes the power blade design over conventional fuel cell modules which are subject to high failure rates from stress failures, overheating, and leaky tubing.

As shown backplate substrate 7025 is capped with an insulating layer 7042 forming the base of a printed circuit board (PCB) facilitating electrical connections among the iBFC components forming the power blade. The PCB substrate itself may comprise a non-conductive material such as fiberglass, fiberglass-reinforced epoxy resin (FR4), epoxies, or polyimide. Conductors may include copper foil laminates such as copper traces 7030. Some portions of the insulating PCB substrate 7042 are removed prior to assembly onto backplate substrate in order to facilitate gas transport such as via window 7022 where gas flows from the backplate's internal gas conduits such as 7021i through the opening 7022 and into μstack pipe nipple 7018 located on the underside of μstack assembly 7009. To prevent gas leakage at the PCB to μstack interface a gasket or grommet 7032 provides an airtight seal between the two.

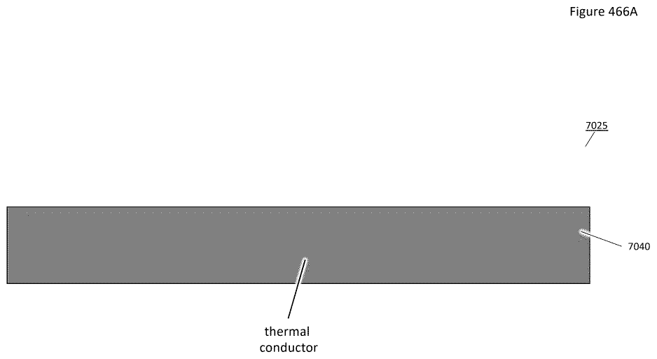

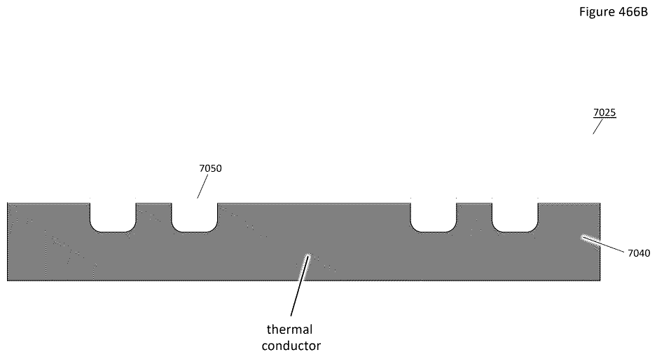

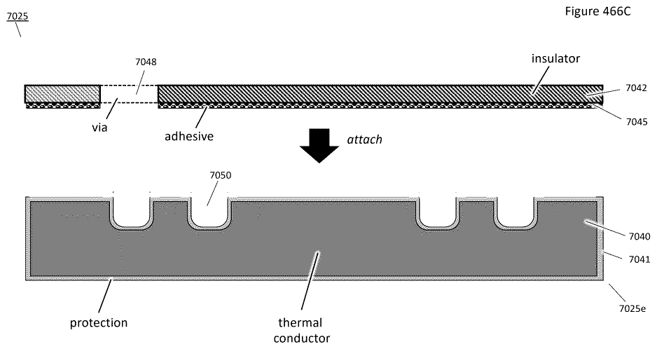

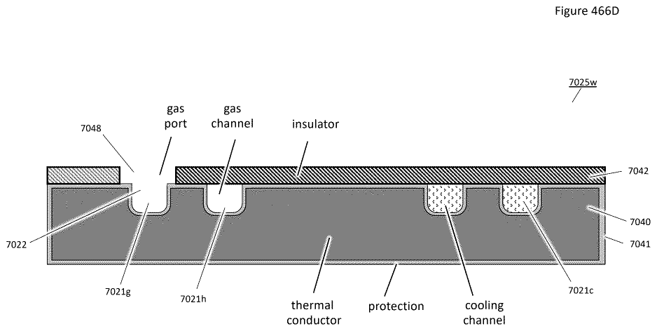

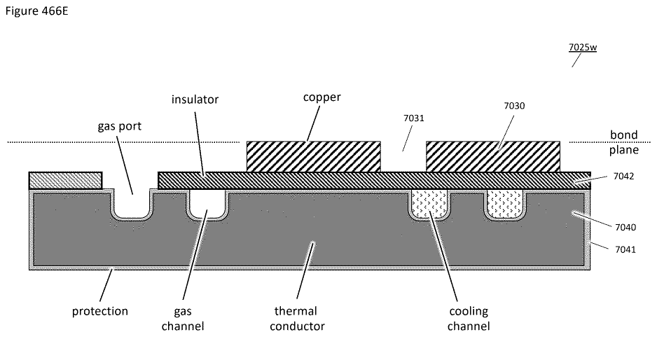

In one embodiment of this invention, fabrication of backplate 7025 starts with thermal conductor 7040 comprising metal, carbon, or composite material as shown in FIG. 466A. Subsequently in FIG. 466B, thermal conductor 7040 is masked and etched to create channels 7050. The etched substrate 7025e is then coated or anodized to prepare a protective layer 7041. In FIG. 466C, substrate 7025e is then bonded to insulator 7042 with adhesive 7045. As shown in the 2D representation of FIG. 466D, insulator 7042 includes a via opening 7048 needed for gas flow between the μstack fuel cell and backplate 7025w. FIG. 466E illustrates copper traces 7030 with gap 7031.

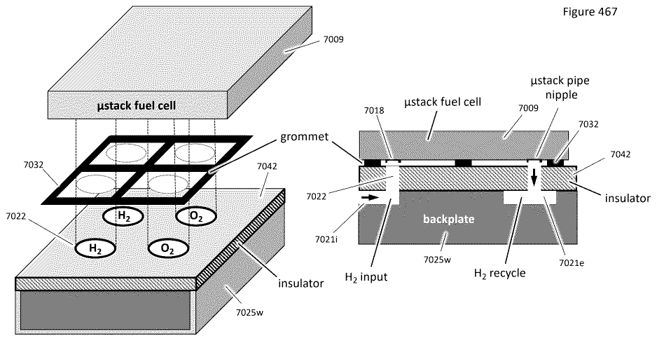

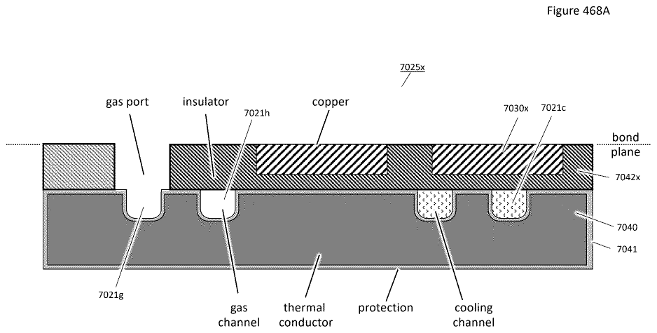

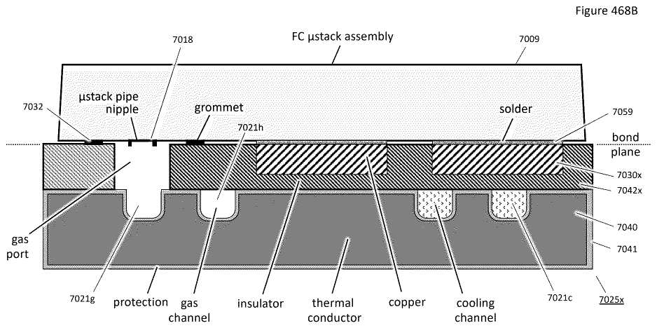

As a unique embodiment of this invention, backplate 7025w comprise a temperature regulated thermally conductive core supporting a printed circuit board substrate of insulator 7042 with copper conductive traces 7030. Because the conductive traces must be thick to carry high currents, e.g. using 4 oz copper, there is naturally a gap 7031 laterally located between traces. Although the gap may be filled with air or an insulator, the connection between backplate gas port and pipe nipple 7018 on the μstack assembly do not sit flush against one another on the bond plane. As described to prevent gas loss in the connection between the two, the design includes a grommet or gasket 7032 to seal the volume against gas leakage. A more detailed description shown in FIG. 467 highlights how grommet 7032 surrounds and seals the connection between gas port 7022 and μstack pipe nipple 7018.

A modification to the backplate, shown in FIG. 468A comprise backplate 7025x where copper traces 7030x form a coplanar surface with electrical insulator 7025x. Fabrication may employ a liftoff procedure or deposition, photomasking, and selective etchback. In one fabrication process,

As shown in FIG. 468B, the attachment of FC μstack assembly 2009 onto backplate 7025x comprises a coplanar interface as a bond plane requiring only a thin grommet or gasket 7032 equal in thickness to solder layer 7059. Such a design made in accordance with this invention greatly reduces the risk of gas leaks.

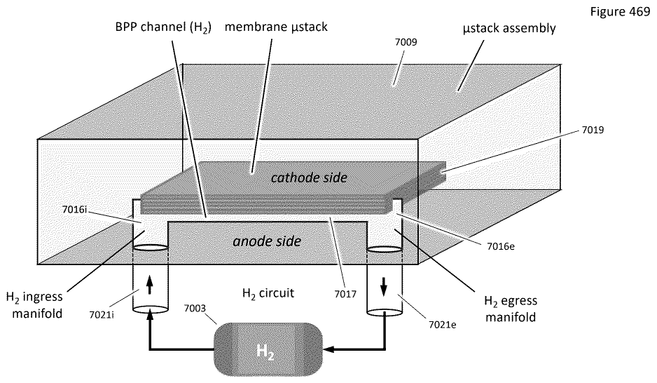

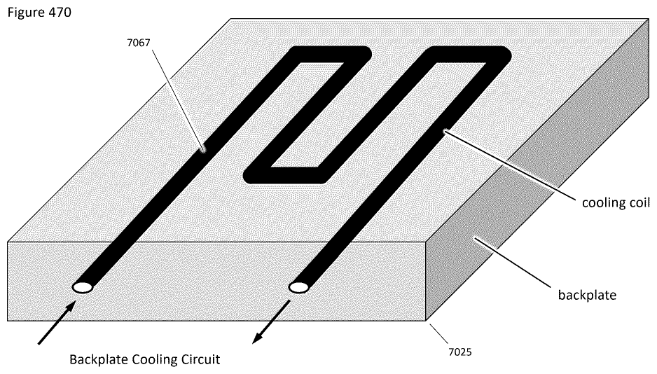

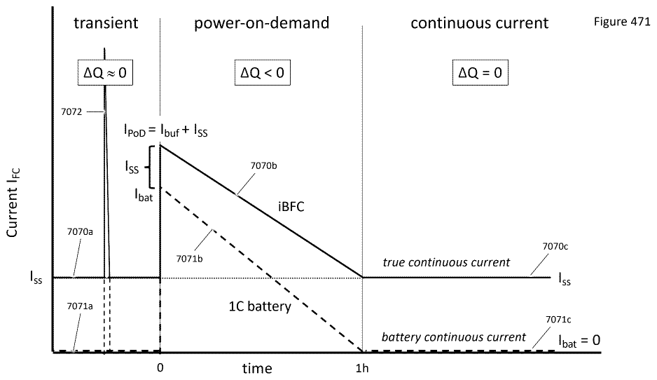

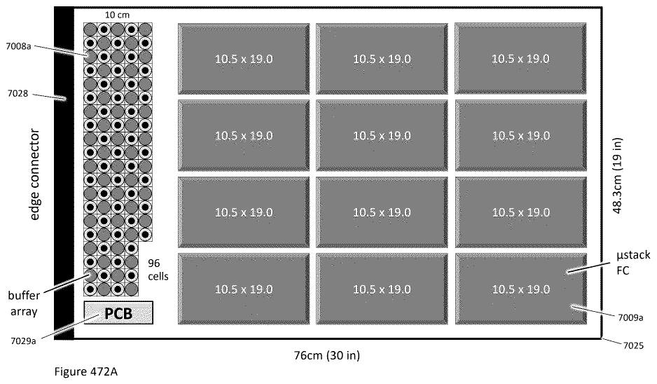

As shown in FIG. 469, the content of μstack assembly 2009 is illustrated in a quasi-3D representation showing hydrogen ingress manifold 7016i, BPP channel 7017, and hydrogen egress manifold 7016e supplying hydrogen to IEM membrane μstack 7019. Hydrogen fuel 7003 forms a closed loops circuit with μstack 7009 through conduits 7021i and 7021e. For clarity's sake, the backplate containing these gas conduits is not shown. Another embodiment of this invention is coolant coil 7027 present in backplate 7025 as shown in FIG. 470. By forcing coolant or water through the backplate a quasi-constant temperature can be maintained during operation.

A variety of designs may be used to form power blades with a minimum power output of 5 kW. Nine different designs are compared in the following table comprising between three and twelve fuel cell μstacks, between 96 and 480 buffer cells, and outputs between 23.3 V and 54.6 V. The designs all utilize a standardized backplate 7025 of area A_{bp}=(48.3 cm)(76 cm)=3671 cm²≈0.36 m². With a 2 U maximum height of 8.89 cm, the unit volume of the power blade is Vol=(8.89 cm)(3671 cm²)=32,635 cm³.

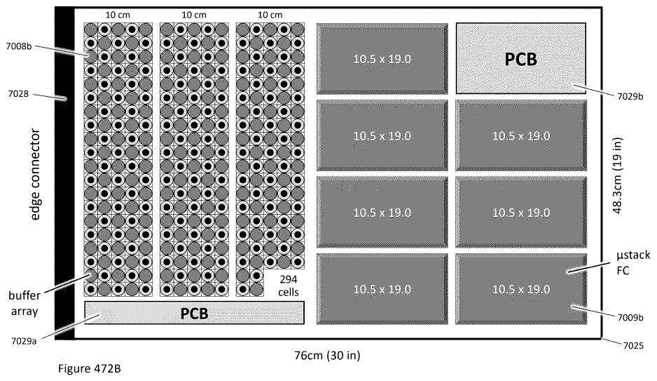

As depicted in FIG. 471, three distinct current ratings are used in this analysis—continuous power Pₛₛ, power-on-demand P_{PoD}, and 10 s transient power P₁₀ₛ. The term ‘continuous power’ is generated power delivered perpetually in a steady-state condition from a primary source of power, converting fuel into electrical energy. Despite false advertising to the contrary, a battery pack cannot deliver continuous power because a battery cannot generate power. It is only an energy storage device. As such the true continuous power of battery pack is zero. As shown by curve 7071c, in continuous power mode there can be no change in the net energy stored in a battery, meaning ΔQ=0. For there to be no net change in the state-of-charge in a battery, the net current flowing in the battery must also be zero, whereby I_{bat}=0 meaning no net current flow into or out of the battery array.

By contrast, the buffer fuel cell disclosed herein has two sources of energy stored in its buffer and energy generated in its fuel from a hydrogen fuel supply. The current output of a buffered fuel cell is thereby I_{BFC}=I_{buf}+I_{FC} where I_{buf}=f(Q_{buf}) depends on the state-of-charge (SoC) in the buffer and I_{FC} does not. Using the same definition of continuous power, the power delivered while ΔQ=0, then there to be no net change in the state-of-charge in a battery in continuous mode. As such the net current flowing in the iBFC buffer must also be zero, whereby I_{bat}=0. In such cases, I_{BFC}=(I_{buf}+I_{FC})=I_{FC}. Since I_{SS}≡I_{FC}=[I_{FC}/A_{FC}](A_{FC}) depends on the design current density [I_{FC}/A_{FC}] and the active area A_{FC} of the fuel cell membranes in the μstack, then for a at 215 mA/cm² a 200 cm² buffered fuel cell delivers I_{SS}=43 A of continuous steady-state current 7070c while a 400 cm² cell delivers I_{SS}=86 A.

The second mode to deliver energy to a load is referred to herein as power-on-demand or PoD. In the case of a battery pack, the only source of power is to deplete charge stored in the battery whereby ΔQ<0. Given that a single string of batteries can deliver a current I_{bat}=(CDR)(ΔQ_{bat}) where ΔQ_{bat}=−(Q_{bat}−Qₘᵢₙ) then the stored charge Q_{bat} declines linearly with time at a constant battery current I_{bat} until ΔQ=0. At a industry standard safe discharge rate of 1 C, the battery current equation simplifies to I_{bat}=(ΔQ_{bat})/(1 h) meaning at a 1 C rate the battery will discharge for one hour as shown by curve 7071b to Qₘᵢₙ after which I_{batt}=0 to avoid battery damage.

By contrast, power on demand discharge for the buffered fuel cell includes bother buffer discharge current I_{buf}=(CDR)(ΔQ_{buf}) and continuously generated fuel cell current I_{FC} whereby I_{PoD}=I_{FC}+I_{buf}=I_{FC}+(CDR)(ΔQ_{buf}) per string. Assuming a 1 C discharge rate the equation simplifies to I_{FC}+I_{buf}=I_{FC}+(ΔQ_{buf})/(1h). Comparing iBFC PoD curve 7070b to 1 C battery curve 7071b two major differences are obvious. Firstly, given the same buffer capacity as battery capacity, Q_{buf}=Q_{bat}, the on-demand current I_{bat} of the battery is less than the buffered fuel cell, the difference being the current I_{SS} generated by the fuel cell.

Secondly when the buffer discharges to ΔQ=0 after one hour, the iBFC current still conducts the steady state current I_{SS} 7070c, e.g. 43 A or 86 A where the battery current drops to zero 7071c. As such the buffered fuel cell delivers more average power during power-on-demand and continues to operate even after the buffer is depleted. A battery only storage system is only good until it is discharged, then is useless until it can be recharged typically over a period of several hours.

Lastly during transient power surges for intervals less than 10 seconds, both the iBFC current and the buffer can conduct current 10 C, an order of magnitude higher normal discharge currents. Given that I_{bat}=I_{buf}=(CDR)(ΔQ_{b})=10C(ΔQ_{b}) either solution can handle high current spike 7072. Academically speaking, the buffered fuel cell offer slightly higher current as during a transient the fuel cell can deliver a transient current double its steady state value without significant losses, namely P₁₀ₛ≡2P_{SS}+10(P_{buf})=V_{buf}(2Iₛₛ+10I_{buf}) where 2P_{SS}=2[I_{FC}/A_{FC}](A_{FC})=(430 mA/cm²)(200 cm²)==86 A. But since this 86 A difference is small compared to a C buffer current, there is no significant difference between curve 7070a and 7071a except that the iBFC can continue to supply current without reducing its transient current capability. If however, a battery state-of-charge is already reduced by previous discharging, its ability to source transient current may also be jeopardized.

With these definitions, a meaningful comparison can be made between various designs.

| # | FC | Voltage | FC | Buffer | Buffer | | | Cont | PoD | | PoD |
|---|---|---|---|---|---|---|---|---|---|---|---|
| FC | Topology | V_{BFC} (V) | I_{FC} (A) | Topology (#) | I_{buf} (A) | | Cont | Pₛₛ (W) | I_{PoD} (A) | | P_{PoD} (W) |
| =int{(n_{FC}) | | =(n_{FC}) | =(m_{FC}) | #buf = int | =(m_{buf}) | | Iₛₛ (A) | =(I_{FC}) | =I_{FC} + | | =(I_{PoD}) |
| (m_{FC})/2400} | | (0.65 V) | (0.215 A) | {(n_{buf})(m_{buf})} | (3.2 A) | | =I_{FC} | (V_{BFC}) | I_{buf} | | (V_{BFC}) |
| 3 | 36s200p | 23.3 V | 43 A | 6s56p (336) | 179 | A | 43 A | 1.0 kW | 222 | A | 5.2 kW |
| 3 | 36s200p | 23.3 V | 43 A | 6s80p (480) | 256 | A | 43 A | 1.0 kW | 299 | A | 7.0 kW |
| 4 | 48s200p | 31.2 V | 43 A | 8s37p (296) | 118 | A | 43 A | 1.3 kW | 161 | A | 5.0 kW |
| 5 | 60s200p | 39.0 V | 43 A | 10s28p (280) | 90 | A | 43 A | 1.7 kW | 133 | A | 5.2 kW |
| 6 | 36s400p | 23.3 V | 86 A | 6s40p (240) | 129 | A | 86 A | 2.0 kW | 215 | A | 5.0 kW |
| 6 | 72s200p | 46.6 V | 43 A | 12s20p (240) | 64 | A | 43 A | 2.0 kW | 107 | A | 5.0 kW |
| 6 | 72s200p | 46.6 V | 43 A | 12s25p (300) | 80 | A | 43 A | 2.0 kW | 123 | A | 5.7 kW |
| 7 | 84s200p | 54.6 V | 43 A | 14s15p (210) | 49 | A | 43 A | 2.4 kW | 92 | A | 5.0 kW |
| 7 | 84s200p | 54.6 V | 43 A | 14s21p (294) | 67 | A | 43 A | 2.4 kW | 110 | A | 6.0 kW |
| 12 | 72s400p | 46.6 V | 86 A | 12s8p (96) | 26 | A | 86 A | 4.0 kW | 112 | A | 5.2 kW |

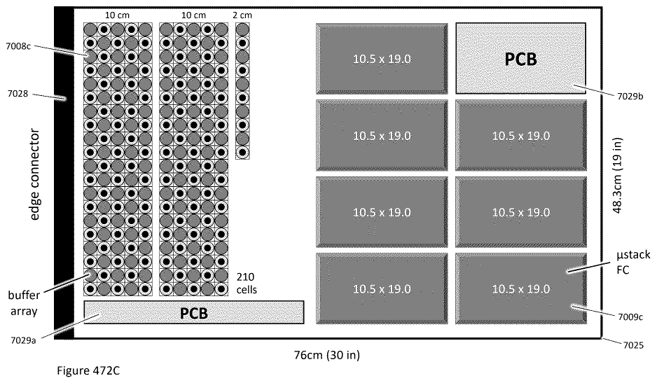

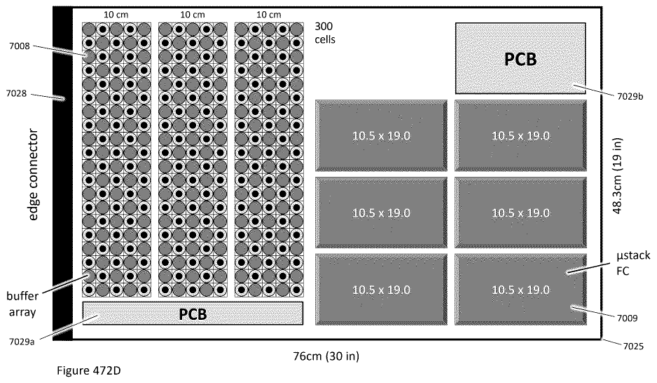

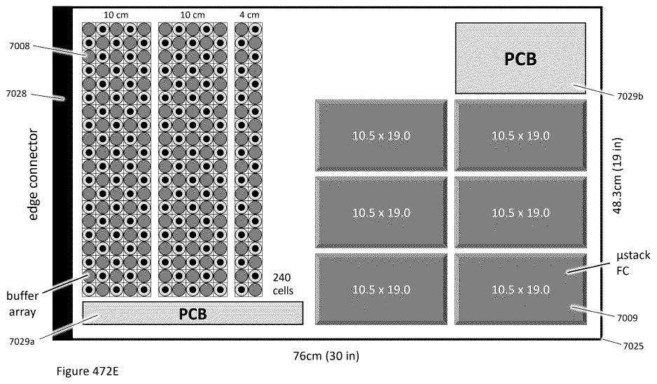

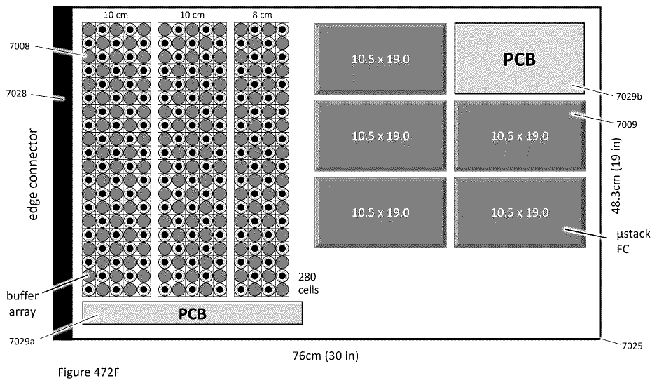

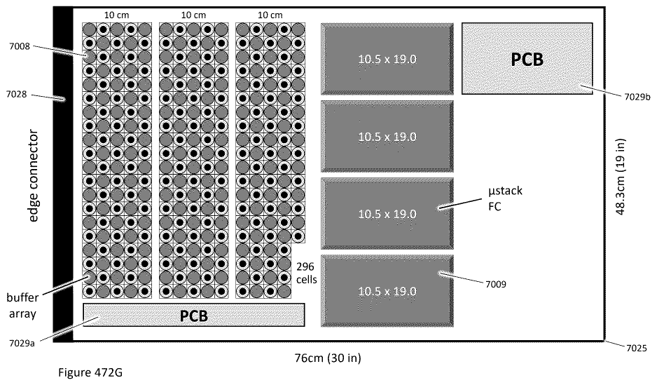

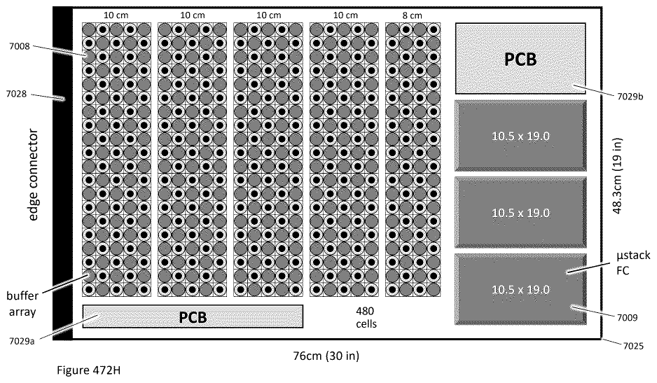

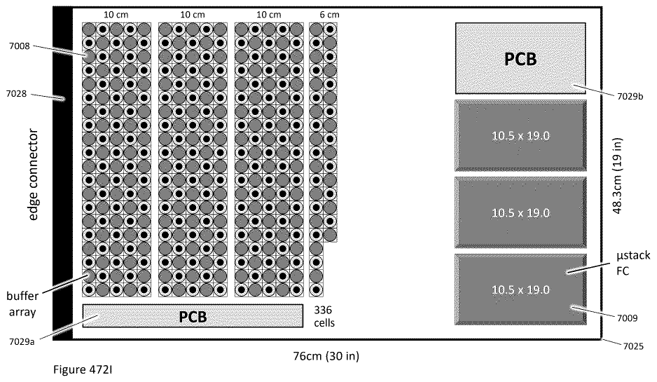

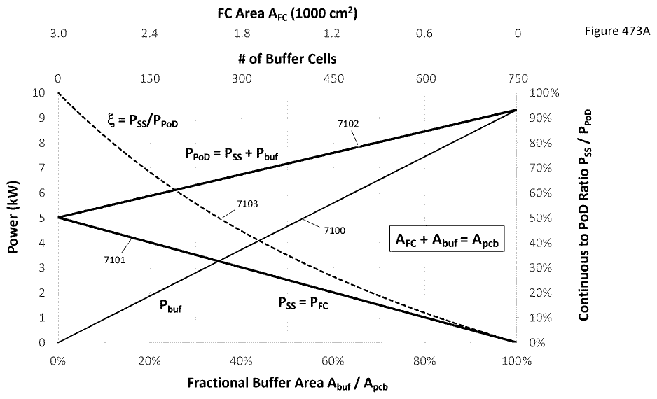

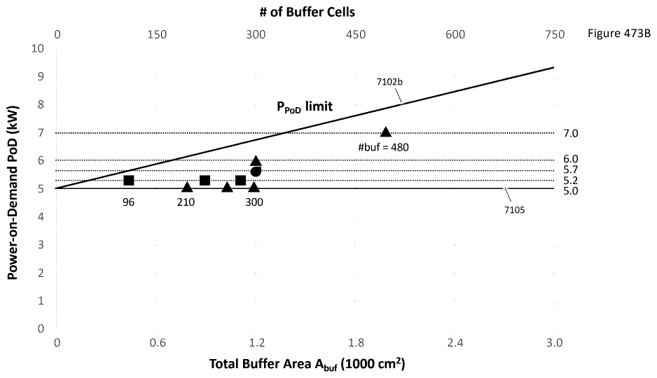

In an exemplary twelve fuel cell design as shown in FIG. 472A comprises a configuration of two parallel strings of six stacks 7009a resulting in a 72s400p FC topology with a 46.6V output at 86 A capable of delivering 4 kW of continuous power. Combined with 96-cell buffer 7008a configured in a 12s8p array is capable of delivering 26 A at a 1 C discharge rate for a total 1 h power-on-demand current of 112 A at 46.6V or 5.2 kW. The ratio of continuous power to power-on-demand is =Pₛₛ/P_{POD}=4.0 kW/5.2 kW=77%. The 10 s transient output for the described power blade made in accordance with this invention is given by P₁₀ₛ=V_{BFC}(2I_{SS}+10(I_{buf}))=(46.6V)(2(86 A)+10(26 A))=(46.6V)(432 A)=20.1 kW. The ratio of 10 s transient power to PoD power is given by ζ=P₁₀ₛ/P_{POD}=20.1 kW/5.2 kW=3.9×.

In another embodiment of this invention, an exemplary seven fuel cell design shown in FIG. 472B comprises a single string of seven μstacks 7009b resulting in a 84s200p FC topology with a 54.6V output at 43 A capable of delivering 2.4 kW of continuous power. Combined with 294-cell buffer 7008b configured in a 14s21p array is capable of delivering 67 A at a 1 C discharge rate for a total 1 h power-on-demand current of 110 A at 54.6V or 6.0 kW. The ratio of continuous power to power-on-demand is ξ=P_{SS}/P_{POD}=2.4 kW/6.0 kW=40%. The 10 s transient output for the described power blade made in accordance with this invention is given by P₁₀ₛ=V_{BFC}(2I_{SS}+10(I_{buf}))=(54.6V)(2(43 A)+10(67 A))=(46.6V)(756 A)=35.2 kW. The ratio of 10 s transient power to PoD power is given by ζ=P₁₀ₛ/P_{PoD}=35.3 kW/6.0 kW=5.9×.

In another embodiment of this invention, an alternate seven fuel cell design shown in FIG. 472C comprises a single string of seven μstacks 7009c resulting in a 84s200p FC topology with a 54.6V output at 43 A capable of delivering 2.4 kW of continuous power. Combined with 210-cell buffer 7008c configured in a 14s15p array is capable of delivering 49 A at a 1 C discharge rate for a total 1 h power-on-demand current of 92 A at 54.6V or 5.0 kW. The ratio of continuous power to power-on-demand is ξ=Pₛₛ/P_{POD}=2.4 kW/5.0 kW=48%. The 10 s transient output for the described power blade made in accordance with this invention is given by P₁₀ₛ=V_{BFC}(2I_{SS}+10(I_{buf}))=(54.6V)(2(43 A)+10(80 A))=(54.6V)(886 A)=48.4 kW. The ratio of 10 s transient power to PoD power is given by ζ=P₁₀ₛ/P_{PoD}=48.4 kW/5.0 kW=9.7×.

In another embodiment of this invention, a six fuel cell design shown in FIG. 472D comprises a single string of six μstacks 7009d resulting in a 72s200p FC topology with a 46.6V output at 43 A capable of delivering 2.0 kW of continuous power. Combined with 300-cell buffer 7008d configured in a 12s25p array is capable of delivering 80 A at a 1 C discharge rate for a total 1 h power-on-demand current of 123 A at 46.6V or 5.7 kW. The ratio of continuous power to power-on-demand is ξ=P_{SS}/P_{POD}=2.0 kW/5.7 kW=35%. The 10 s transient output for the described power blade made in accordance with this invention is given by P₁₀ₛ=V_{BFC}(2I_{SS}+10(I_{buf}))=(46.6V)(2(43 A)+10(80 A))=(46.6V)(886 A)=41.2 kW. The ratio of 10 s transient power to PoD power is given by ζ=P₁₀ₛ/P_{PoD}=3 41.2 kW/5.7 kW=7.2×.

In alternate embodiment of this invention, another six fuel cell design shown in FIG. 472E comprises a single string of six μstacks 7009e resulting in a 72s200p FC topology with a 46.6V output at 43 A capable of delivering 2.0 kW of continuous power. A 240-cell buffer 7008e configured in a 12s20p array is capable of delivering 64 A at a 1 C discharge rate for a total 1 h power-on-demand current of 107 A at 46.6V or 5.0 kW. The ratio of continuous power to power-on-demand is =Pₛₛ/P_{POD}=2.0 kW/5.0 kW=40%. The 10 s transient output for the described power blade made in accordance with this invention is given by P₁₀ₛ=V_{BFC}(2I_{SS}+10(I_{buf}))=(46.6V)(2(43 A)+10(64 A))=(46.6V)(726 A)=34 kW. The ratio of 10 s transient power to PoD power is given by ζ=P₁₀ₛ/P_{PoD}=34 kW/5.7 kW=6.0×.

In a different six fuel cell design also exemplified by previously shown FIG. 472E two strings of three μstacks 7009e result in a 36s400p FC topology with a 23.3V output at 86 A also capable of delivering 2.0 kW of continuous power. A 240-cell buffer 7008e configured in a 6s40p array is capable of delivering 129 A at a 1 C discharge rate for a total 1 h power-on-demand current of 215 A at 23.3V, also equivalent to 5.0 kW PoD power output. As in the previous design, the ratio of continuous power to power-on-demand is =Pₛₛ/P_{POD}=2.0 kW/5.0 kW=40%. The 10 s transient output for the described power blade made in accordance with this invention is given by P₁₀ₛ=V_{BFC}(2I_{SS}+10(I_{buf}))=(23.3V)(2(86 A)+10(129 A))=(23.3V)(1462 A)=34 kW. The ratio of 10 s transient power to PoD power is given by ζ=P₁₀ₛ/P_{PoD}=34 kW/5.7 kW=6.0×. From this comparison, it is clear the same power output can be achieved by either doubling the voltage and halving the current or vice versa. Pragmatically however managing high voltage is easier than managing high currents because parasitic resistance increases insertion losses in proportion to the square of the current, i.e. I²R.

In another embodiment of this invention, an five fuel cell design shown in FIG. 472F comprises a single string of five μstacks 7009f resulting in a 60s200p FC topology with a 39.0V output at 43 A capable of delivering 1.7 kW of continuous power. Combined with 280-cell buffer 7008f configured in a 10s28p array is capable of delivering 90 A at a 1 C discharge rate for a total 1 h power-on-demand current of 133 A at 39.0V or 5.2 kW. The ratio of continuous power to power-on-demand is =Pₛₛ/P_{POD}=1.7 kW/5.2 kW=33%. The 10 s transient output for the described power blade made in accordance with this invention is given by P₁₀ₛ=V_{BFC}(2I_{SS}+10(I_{buf}))=(39.0V)(2(43 A)+10(90 A))=(54.6V)(986 A)=38.5 kW. The ratio of 10 s transient power to PoD power is given by ζ=P₁₀ₛ/P_{PoD}=38.5 kW/5.2 kW=7.4×.

In yet another embodiment of this invention, an four fuel cell design shown in FIG. 472G comprises a single string of four μstacks 7009g resulting in a 48s200p FC topology with a 31.2V output at 43 A capable of delivering 1.3 kW of continuous power. Combined with 296-cell buffer 7008g configured in a 8s37p array is capable of delivering 118 A at a 1 C discharge rate for a total 1h power-on-demand current of 161 A at 31.2V or 5.0 kW. The ratio of continuous power to power-on-demand is ξ=P_{SS}/P_{POD}=1.3 kW/5.0 kW=26%. The 10 s transient output for the described power blade made in accordance with this invention is given by P₁₀ₛ=V_{BFC}(2I_{SS}+10(I_{buf}))=(31.2V)(2(43 A)+10(118 A))=(31.2V)(1266 A)=39.5 kW. The ratio of 10 s transient power to PoD power is given by ζ=P₁₀ₛ/P_{PoD}=39.5 kW/5.0 kW=7.9×.

In a lower voltage embodiment of this invention, an three fuel cell design shown in FIG. 472H comprises a single string of three μstacks 7009h resulting in a 36s200p FC topology with a 23.3V output at 43 A capable of delivering 1.0 kW of continuous power. Combined with 480-cell buffer 7008h configured in a 6s80p array is capable of delivering 256 A at a 1 C discharge rate for a total 1 h power-on-demand current of 299 A at 23.3V or 7.0 kW. The ratio of continuous power to power-on-demand is ξ=P_{SS}/P_{POD}=1.0 kW/7.0 kW=14%. The 10 s transient output for the described power blade made in accordance with this invention is given by P₁₀ₛ=V_{BFC}(2I_{SS}+10(I_{buf}))=(23.3V)(2(43 A)+10(256 A))=(23.3V)(2646 A)=61.7 kW. The ratio of 10 s transient power to PoD power is given by ζ=P₁₀ₛ/P_{PoD}=61.7 kW/7.0 kW=8.8×.

Lastly in yet another low voltage embodiment of this invention, an three fuel cell design shown in FIG. 472I comprises a single string of three μstacks 7009i resulting in a 36s200p FC topology with a 23.3V output at 43 A capable of delivering 1.0 kW of continuous power. Combined with 336-cell buffer 7008i configured in a 6s56p array is capable of delivering 179 A at a 1 C discharge rate for a total 1 h power-on-demand current of 222 A at 23.3V or 5.2 kW. The ratio of continuous power to power-on-demand is ξ=P_{SS}/P_{POD}=1.0 kW/5.2 kW=19%. The 10 s transient output for the described power blade made in accordance with this invention is given by P₁₀ₛ=V_{BFC}(2I_{SS}+10(I_{buf}))=(23.3V)(2(43 A)+10(179 A))=(23.3V)(1873 A)=43.6 kW. The ratio of 10 s transient power to PoD power is given by ζ=P₁₀ₛ/P_{PoD}=43.6 kW/5.2 kW=8.4×.

### Comparing 5 kW Power Blade Designs.

To compare various 5 kW power designs an areal power density model of both buffer and fuel cell performance is required. Although, in practice both components come in only discrete quantized areas, for example 200 cm² for a fuel cell, when creating a model we can assume a granularity of 4 cm² minimal required PCB area for an 18650 lithium ion cell and 1 cm² increments for fuel cell active areas to fill in the remaining unused area. The standard PCB area for a rack mounted cage is 76 cm×48.3 cm equaling 3671 cm². Assuming on 82% areal utilization, the resulting usable active area of the PCB is A_{pcb}=3000 cm².

To determine power density, the fabricated fuel cell membranes characterized herein exhibited minimal voltage sag at a current density of [I_{FC}/A_{FC}]=215 mA/cm². This current density is consistent with the previous analysis for the continuous steady state power of a fuel cell where I_{FC}=[I_{FC}/A_{FC}](A_{FC})=(215 mA/cm²)(200 cm²)=43 A. Assuming a n_{FC}=12 layer stack with a minimum voltage of V_{FC}=0.65V per layer under low humidity condition, then the minimum μstack voltage is given by V s(min)=(n_{FC})(V_{FC})=12(0.65V)=7.8V and the maximum voltage in high humidity is by V_{μs} (max)=(n_{FC})(V_{FC})=12(0.9V)=10.8V, 38% higher than the minimum μstack voltage.

The power density is then given by [P_{FC}(min)/A_{FC}][I_{FC}/A_{FC}](V_{FC})=(215 mA/cm²)(7.8V)=1.7 W/cm² increasing by 38% to 2.4 W/cm² in humid conditions. This means for a reference area of m_{FC}=200, the output power is P_{FC}(min)=[P_{FC}(min)/A_{FC}](A_{FC})=[1.7 W/cm²](200 cm²)=340 W which is the approximately the same as P_{FC}(min)=(I_{FC})(V_{FC})=(43 A)(7.8V)≈335 W accounting for rounding errors. In essence at low humidity three 200 cm² stacks produce 1 kW minimum and 1.4 kW maximum.

To determine the areal power density of a lithium ion cell, the required printed circuit board of 18650 cells with diameters of 1.8 cm are positioned in a rectangular grid indexed by 2 cm in both planar axis. The resulting area is A_{bat}=A_{buf}=(2 cm)²=4 cm² per cell. Note the area A_{buf} is the PCB area used by each perpendicularly mounted Li-ion cell, not the active area of the separator rolled up inside the battery. Using nominal characteristics for 18650 Li-ion cells each cell exhibits an average current at 1 C discharge rate of I_{bat}=l_{buf}=3200 mA with a corresponding area current density of [I_{buf}/A_{buf}]=(3200 mA)/(4 cm²)=800 mA/cm². The nominal voltage for each cell V_{bat}=V_{buf}=3.9V at a 1 C discharge rate. The corresponding power density of the cell is [P_{buf}/A_{buf}]=[I_{buf}/A_{buf}](V_{buf})=(800 mA/cm²)(3.9V)=3.1 W/cm². By comparison the areal power of the fuel cell ranges from 1.7 4 W/cm² to 2.4 W/cm², roughly 45% to 23% lower than a battery, depending on relative humidity. Of course, the fuel cell is able to perpetually deliver power while a battery can only deliver power at a 1 C discharge rate for one hour. Given each Li-ion cell occupies 4 cm² of PCB board space, the power delivered at 1 C rate from a single Li-ion cell is P_{buf}=[P_{buf}/A_{buf}](A_{buf})=[3.1 W/cm²](4 cm²)=12.4 W per cell.

Normalizing the buffer cell to a 200-cm² area means one standard 335 W μstack fuel cell occupies the same area as 50 buffer cells capable of delivering P_{buf}(1 C)=(#buf)(P_{b}˜f/cell)=(50)(12.4 W/cell)=620 W for one hour where #buf=n_{FC}m_{FC}. This areal power output compares to a fuel cell supplying 335 W at low humidity and 460 W in humid conditions. It should be noted that although this comparison is areal, i.e. normalized to the same area, it is also relatively accurately volumetrically since the height of the fuel cell stack and the height an 18650 cell including mounting hardware are roughly equal and under 2 U height in instrument rack vernacular. Weight is calculated by 45 g/cell for Li-ion and for fuel cells by bipolar plates (49%), end caps (28%), and GDLs (20%).

| Com- | | | | | | | | |
|---|---|---|---|---|---|---|---|---|
| ponent | 1 cell Li-ion | | 12-layer μstack FC | | | | | |
| Dis- | 1 C rate | | nominal | | | | double | |
| charge | | | density | | | | density | |
| Duration | 1 | hour* | perpetual | | | | thermal | |
| | | | (steady state) | | | | limit | |
| Current | 800 | mA/ | 215 | | mA/cm² | | 430 | mA/ |
| density | | cm² | | | | | | cm² |
| Current/ | 3.20 | A | 0.86 | | A | | 1.72 | A |
| 4 cm² | | | | | | | | |
| unit | | | | | | | | |
| Current/ | 160 | A | 43 | | A | | 86 | A |
| 200 | | | | | | | | |
| cm² cell | | | | | | | | |
| Humidity | — | | low | | high | | low | |
| Voltage | 3.9 | V | 7.8 | V | 10.8 | V | 7.8 | V |
| Power | 3.1 | W/cm² | 1.7 | W/cm² | 2.4 | W/cm² | 3.4 | W/cm² |
| density | | | | | | | | |
| Power/ | 12.4 | W* | 6.8 | W | 9.6 | W | 13.6 | W |
| 4 cm² | | | | | | | | |
| unit | | | | | | | | |
| Power/ | 620 | W* | 340 | W | 480 | W | 680 | W |
| 200 | | | | | | | | |
| cm² cell | | | | | | | | |

| | | | |
|---|---|---|---|
| Weight/ | 2.25 | kg | 0.4 kg |
| 200 | | | |
| cm² cell | | | |

Specifically the 2.25 kg weight of fifty Li-ion buffer cells is nearly six times greater than a 12 layer μstack occupying the same 200 cm² of PCB space weighing only 400 g. Scaling the occupied PCB area by fifteen times to 3000 cm², the active area of a power blade's printed circuit board, allows a direct estimate of the weight and gravimetric energy density of various iBFC designs.

| #FC | #buf | % A_{FC} | % A_{buf} | P_{SS} | | P_{PoD} | Wt FC | | Wt buf | | Wt total | | P Density |
|---|---|---|---|---|---|---|---|---|---|---|---|---|---|
| n_{FC}m_{FC} | n_{buf}m_{buf} | A_{FC}/A_{pcb} | A_{buf}/A_{pcb} | I_{FC}V_{FC} | | P_{FC} + P_{buf} | 400 g/FC | | 45 g/cell | | Σ Wt | | P_{PoD}/Wt |
| 0 | 750 | 0% | 100% | 0 | kW | 9.3 kW | 0 | kg | 33.8 | kg | 33.8 | kg | 275 W/kg |
| 3 | 480 | 20% | 64% | 1.0 | kW | 7.0 kW | 1.2 | kg | 21.6 | kg | 22.8 | kg | 307 W/kg |
| 3 | 336 | 20% | 45% | 1.0 | kW | 5.2 kW | 1.2 | kg | 15.1 | kg | 16.3 | kg | 319 W/kg |
| 4 | 296 | 27% | 39% | 1.3 | kW | 5.0 kW | 1.6 | kg | 13.2 | kg | 14.8 | kg | 338 W/kg |
| 5 | 280 | 33% | 37% | 1.7 | kW | 5.2 kW | 2.0 | kg | 12.6 | kg | 14.6 | kg | 356 W/kg |
| 6 | 300 | 40% | 40% | 2.1 | kW | 5.7 kW | 2.4 | kg | 13.5 | kg | 15.9 | kg | 358 W/kg |
| 7 | 294 | 47% | 39% | 2.4 | kW | 6.0 kW | 2.8 | kg | 13.2 | kg | 16.0 | kg | 375 W/kg |
| 12 | 96 | 80% | 13% | 4.0 | kW | 5.2 kW | 4.8 | kg | 4.3 | kg | 9.1 | kg | 570 W/kg |
| 15 | 0 | 100% | 0% | 5.1 | kW | 5.1 kW | 6.0 | kg | 0 | kg | 6.0 | kg | 850 W/kg |

From the foregoing summary, varying the number of fuel cell μstacks from 3 to 12 and simultaneously varying the number of buffer cells from 480 to 96 in inverse proportion results in a the fuel cell varying from 20% to 80% of the available power blade's PCB area, while the buffers occupy between 64% and 13% of the available area. The overall PCB utilization, i.e. the fractional sum of (% FC+% buf) vary non-monotonically between 65% and 93%. All designs deliver a power-on-demand minimum output power of 5 kW. Net weight also varies non-monotonically between 22.8 kg and 9.1 kg with a nominal weight of 15 kg per power blade.

These practical designs are bounded by two extreme cases not classified as buffered fuel cells, namely a 100% fuel cell version delivering 5.2 kW of PoD weighing only 9 kg, contrasted against a 100% buffer version with a PoD output of 7 kW weighing nearly 34 kg. The net result is the spectrum of designs exhibit a monotonic variation in power density between 275 W/kg for a pure battery system and 850 W/kg for a fuel cell only implementation. All iBFCs varied from 307 to 375 W/kg except for the twelve fuel cell version having a gravimetric power density of 570 W/kg.

These power densities should not be confused with energy densities. Although the relationship between energy density and power density for a lithium ion cell is essentially one for one, i.e. x kWh=x kW∝#buf, that relation is not true for a fuel cell. For a fuel cell, its power output is based on its number of layers and its membrane area PFC∝(n_{FC})(A_{FC}) but its continuous power is limited only by its available fuel E_{FC}=[33 kWh/kg H₂](Wt H₂) so long that the fuel cell is sufficiently large to deliver the total energy over the required period of time, vis-à-vis where P_{FC}≥E_{FC}/Δt. For example, so long that a fuel cell has a power output capability of 1.4 kW, it is able to deliver 33 kWh of energy indefinitely as long as it has fuel. Once the minimum power condition is met, the fuel cell total available energy has nothing to do with its power rating.

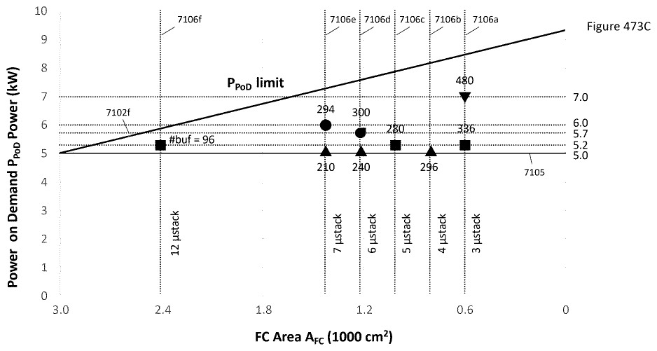

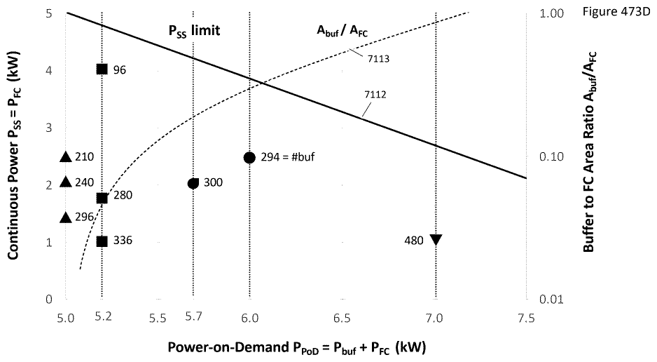

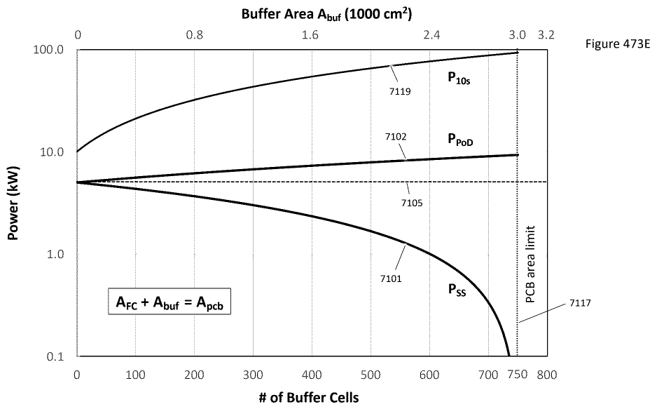

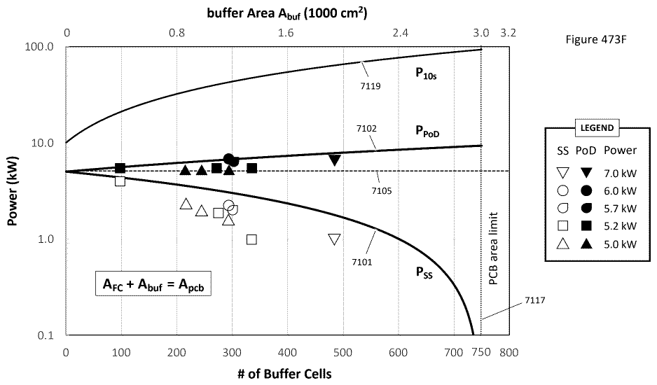

As shown in FIG. 473A, the output power of a iBFC power blade is plotted against the fractional area of the PCB allocated to buffer cells, i.e. A_{buf}/A_{pcb} where the sum of the buffer cell area A_{buf} and the fuel area A_{FC} equal a constant A_{pcb}. As depicted, when A_{buf}=0 and #buf=0 cells, then A_{FC}=P_{pcb}=3000 cm². Given a power density of 1.7 W/cm², the fuel-cell steady-state power output is given by P_{FC}=[P_{FC}/A_{FC}](A_{pcb})=(1.7 W/cm²)(3000 cm²)≈5 kW.

As shown by curve 7101, any increase in the area allocated to buffer cells linearly decreases the fuel cell area and generated power P_{FC} but correspondingly increases the buffer power P_{buf} shown by curve 7100. The sum of the two power components, referred to as power-on-demand P_{PoD}=P_{buf}+P_{SS} shown by curve 7102 increases in proportion to buffer area A_{FC}. The total power increases to when #buf=750 where A_{buf}=3000 cm², where the power is equal to P_{buf}=P_{PoD}=[P_{buf}/A_{buf}](A_{buf})=[3.1 W/cm²](3000 cm²)=9.3 kW. As shown, the ratio of continuous power Pₛₛ to power-on-demand P_{PoD}, where ξ=P_{SS}/P_{PoD} is shown by curve 7103.

FIG. 473B illustrates the power-on-demand power limit P_{PoD} 7102b as a function of buffer area A_{buf} including data points from the aforementioned designs at 5 kW shown by line 7105, along with designs at 5.2 kW, 5.7 kW, 6.0 kW and 7 kW.

FIG. 473C illustrates the power-on-demand power limit P_{PoD} 7102f as a function of fuel cell area A_{FC} including data points from the aforementioned designs at 5 kW shown by line 7105 comprising 3 fuel cells 7106a, 4 fuel cells 7206b, 5 fuel cells 7205c, 6 fuel cells 7205d, 7 fuel cells 7205e, and 12 fuel cells 7205f.

FIG. 473D illustrates a plot of continuous power versus power-on-demand including P_{SS} limit 7112. The relative area ratio A_{buf}/A_{FC} 7113 is included on the second y-axis.

FIG. 473D contrasts the 10-second transient power P₁₀ₛ shown by curve 7119 to the power-on-demand power P_{PoD} 7102 and steady-state power P_{SS} 7101 as a function of the number of buffer cells #buf in the iBFC power blade where the maximum number of cells 7117 equals to 750.

FIG. 473F illustrates the same curve but with specific power blade designs added including PoD for 5 kW (triangle), 5.2 kW (square), 5.7 kW (teardrop), 6.0 kW (circle), and 7.0 kW (inverted triangle). The solid markers represent the power-on-demand while the clear markers represent steady state power output. The ratio of 10 second transient power to power on demand, i.e. ζ=P₁₀ₛ/P_{PoD} is roughly 2× in designs with few buffer cells and approaches 10× as #buf→750.

### Energy Bank Autonomous Power System.

An autonomous hydrogen power system made in accordance with this invention comprises a power generation and storage system referred to herein as an energy bank capable of supplying electrical power to a home, business, or microgrid supplying multiple users. When operating off grid, i.e. without relying on public utilities for electrical energy, the system is able to operate fully autonomously where the self generated power is equal to the electrical load demand which it powers. Alternatively the system may operate quasi-autonomously where the generated power is used to supplement or cost-reduce other sources of power.

In fully autonomous mode, the energy bank is able to produce and supply energy indefinitely so long that a fuel supply is made available. Operating in a manner analogous to a gas-powered water heater, so long that fuel is available the operation of the energy bank will supply electricity without even being noticed. As such, the energy bank is not a battery backup system with limited energy consumed after a few hours of use. Instead it can be considered as a primary source of power converting fuel into electricity perpetually. Moreover the iBFC based energy bank integrates its own secondary power storage to handle periods of high peak demand.

As disclosed herein, the intelligent buffered fuel cell (iBFC) is the core component of the energy bank used to realize an efficient environmentally-friendly alternative to grid power and public utilities. Depending on user requirements the energy bank may be configured with one or more iBFCs connected in series, parallel, or series-parallel circuits. Each iBFC includes a combination of fuel cells, electrochemical buffers, and a charge transfer regulator used to control energy flow. In one set of embodiments, the fuel cells employ a proton exchange membrane (PEM) to generate electricity from a cationic fuel source such as hydrogen or methanol. In another embodiment the system utilizes anionic fuel cells (AEMs) able to convert hydroxide or other alkali fuels into electricity.

Regardless of whether the ion exchange membrane (IEM) is cationic or anionic, the generated electricity is stored in an electrochemical buffer coulombically, generally comprising an array of lithium ion cells or other emerging charge storage chemistries. In operation, a charge transfer regulator (QXR) controls energy flow between the fuel cell and buffer, both limiting the current demand drawn from the fuel cell to mitigate voltage sag while properly charging the battery at a prudent level of current and within a prescribed safe voltage range. The charging algorithms may include constant voltage mode, constant current mode, or sequencing thereof, including protection against overcharge, over-discharge, over-temperature, and cell voltage imbalances. The buffer may be charged from fuel generated electricity or from an external electrical source, directly charging the buffer array. The operational details of the iBFC are described in greater detail in a related application “Intelligent Buffered Fuel Cell with Low Impedance” and will not be described further here.

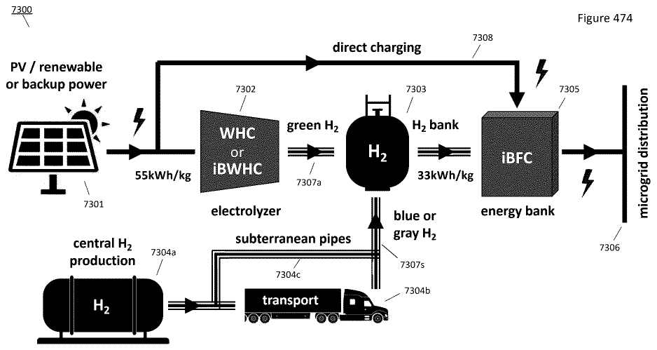

In one embodiment shown in FIG. 474, an autonomous hydrogen power system 7300 comprises a hydrogen bank 7303 used to power a microgrid electric distribution system 7306 by converting hydrogen into electric power in iBFC energy bank 7305. The average conversion rate of the iBFC in steady state operation of the buffered fuel cell does not limit normal daily power consumption for most designs presented. Specifically, since the average daily energy use for most homes or small offices is between 30 kWh and 33 kWh, a single kilogram of hydrogen can supply a full day of off-grid power.

Made in accordance with this invention, the power output rating of an energy bank able to generate this amount of power in one 24-hr day is thereby given by P_{SS}≥E/Δt=33 kWh/24 hr≥1.3 kW. In other words, any energy bank with a power output rated at 1.3 kW or greater is able to supply a full day's power without drawing down stored charge in its buffer. To handle periods of high demand the fuel cell and the buffer work together to deliver a power-on-demand output of 5 kW to 7 kW depending on the design, after which the fuel cell replenishes the buffer's lost charge.

Referring the 5 kW power blade design table and graphs, only those designs with three fuel cells and P_{SS}=1 kW fall short of the 1.3 kW output necessitated by fully-autonomous operation at daily energy breakeven. That said, the 1 kW rating is rated at low humidity. In high humidity environs, the steady-state output of even the three fuel cell iBFC energy bank increases to 1.4 kW, meaning any of the 5 kW power blades described herein are able to autonomously meet all daily energy production needs by hydrogen conversion.

Another consideration in autonomous power generation is the source of hydrogen used in the energy bank which may be (i) purchased from a hydrogen supplier, or (ii) made autonomously on location. As illustrated in the previously cited FIG. 474, the hydrogen supply to hydrogen bank 7303 can come from a variety of sources, either from commercially supplied central hydrogen production 7304a or from hydrolysis using an electrolyzer such as water-to-hydrogen converter 7302. In the case of commercial hydrogen, any variety of sources are available. See the previous section on hydrogen production for more details. Primary power for hydrogen generation include both renewable and non-renewable energy sources.

One of the lower cost solutions involves conversion of natural gas into hydrogen with or without carbon sequester, referred to as gray or blue hydrogen respectfully. Costs vary by region but in 2024 gray hydrogen can be acquired wholesale in bulk at $1 US per kilogram, equivalent to $0.03 per kWh, significantly lower than electric grid power today. Commercially generated hydrogen 7304a may be supplied 7307 as via tanks or canisters transported 7304b from central production facilities 7304a to commercial outlets such as gas stations or convenience stores, or supplied in bulk to high volume consumers such as smart grid facilities, energy storage facilities. Bulk liquid hydrogen shipments may also be supplied heavy users like cloud computing, server farms, A1 central hosts, supercomputers, crypto miners, and cloud network providers. In high volume or mission critical applications, hydrogen gas can also be delivered using subterranean pipes 7304c.

Another hydrogen production method suitable for autonomous energy involves hydrolysis—the electrolytic splitting of water into hydrogen and oxygen. In hydrolysis, water is catalytically broken into its constituent H₂ and O₂ gasses, where the hydrogen is ionized by a catalyst into protons and transported across an ion exchange membrane under the influence of an electric field. Once arriving in the cathode the proton and electrons recombine to produce elemental hydrogen and hydrogen gas molecules ready for storage.

As such, hydrolyzer 7302 converts power from an electric source such as PV solar panel 7301 into hydrogen 7307a to be stored in hydrogen bank 7303 for later use. Alternatively, a portion of the solar electric current can be diverted to energy bank 7309 and stored coulombically. If the source of power driving the electrolyzer comprises renewable energy from wind or solar PV, the hydrogen produced 7307a is considered ‘green hydrogen’. Commercial green hydrogen is available for $5 to $7 US per kilogram. Self made hydrogen, by contrast costs $0 per kWh after the capital expense is recovered or written off.

One limitation of the architecture of autonomous hydrogen power system 7300 is the delicate balance required between the electrical energy source illustrated as PV solar panel 7301 and the hydrogen output rate of the water to-hydrogen electrolyzer depicted as iBWHC 7302. Should the source of electrical power be less than the optimum power required to maximize the rate of hydrogen evolution 7307a, then less hydrogen will be produced for lack of energy. In other words, the hydrolyzer will be operating below its capacity and the potential to generate and store energy will underperform expectations.

Conversely if the source of electrical power 7301 exceeds the maximum conversion rate of hydrolyzer 7302, then excess electricity will be generated that the hydrolysis can't use. Electrical energy will be wasted as heat without ever being converted into storable hydrogen fuel. This problem can be averted by routing excess power to buffer for direct charging 7308 within energy bank 7305, a least temporarily.

Once the buffer is fully charged however, excess PV power will be lost if water-to-hydrogen conversion of electrolyzer 7302 cannot keep up. Complicating matters further, for most sources of renewable power, be it PV solar or wind generation, the electrical output is not steady nor perpetual. PV solar only produces power when the sun is shining in the daylight hours. Wind power is only generated when the wind is blowing. Even a non-renewable power source such as an emergency diesel or gasoline generator is problematic as it cannot be used at night without violating city anti-noise ordinances. This means the electrical power used to power the hydrolyzer is only available part of the day and at inconsistent power levels.

One embodiment of this invention is to replace the conventional water-to-hydrogen converter (WHC) comprising electrolyzer 7302 with a more advanced system, an intelligent buffered water to hydrogen converter or ‘iBWHC’. In the iBWHC, the electrical input to the electrolyzer includes a battery array used to store excess electricity generated by the primary electrical power source 7301 such as a PV solar or wind system until the hydrolysis processor can catch up with the energy surplus. While as a stand alone unit, inclusion of a buffer improves the throughput of electrolyzer 7302 avoiding the need for a more-expensive higher capacity electrolytic converter, it does add cost to include the electrical buffer cells.

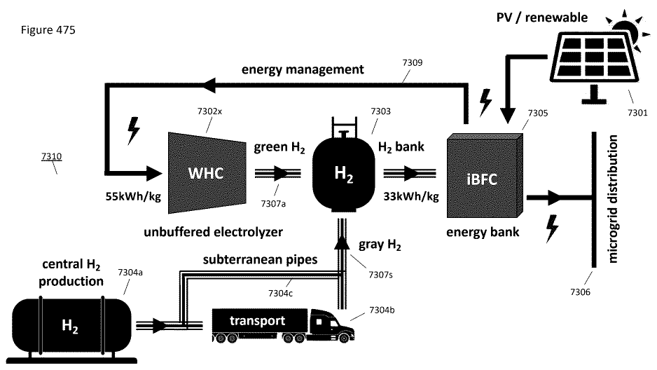

An alternative more cost effective approach shown in FIG. 475 comprises an alternate autonomous hydrogen energy system which avoids the need to buffer the hydrolyzer. In this implementation the primary power source 7301 is fed directly into the buffer cells of iBFC energy bank 7305. The energy bank then stores excess electrical power either for its microgrid 7306 distribution system to homes and businesses, or to provide a power source to an unbuffered WHC electrolyzer 7302x. In this manner the buffer cells in the iBFC energy bank 5305 perform three duties (i) to store electrical power received from the fuel cell and from primary power inputs; (ii) to power the microgrid output; and (iii) to power the electrolysis of water into hydrogen.

### Improved Water-to-Hydrogen Electrolysis.

The inverse function of a membrane fuel cell which converts hydrogen and oxygen into water and electricity is the electrochemical process of ‘water hydrolysis’, an electrolytic reaction converting water and electricity into hydrogen and oxygen. In electrolysis at the anode, water oxidation results in the release of oxygen gas (O₂), mobile protons (H⁺), and hydronium ions (H₃O) by the oxygen evolution reaction (OER), not mass balanced

H₂O(I)→O₂(g)+(H⁺(aq)+H₃O⁺(aq))+e⁻

where the parenthetical lowercase letter (1) indicates liquid, (aq) indicates aqueous meaning ‘in solution’, and (g) refers to the gaseous state of matter. Hydrogen ions liberated in the anode catalyst layer ACL 7404a migrate through the IEM 7405 electrolyte to the cathode catalyst layer 7404c either as protons (H⁺) or as hydronium ions (H₃O⁺). At the cathode, reduction of protons occurs leading to the production of hydrogen gas (H²) conducted through the cathode gas diffusion layer (KGDL) 7403c via the corresponding reaction represented by the hydrogen evolution reaction (HER):

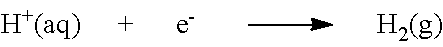

Overall, PEM hydrogen electrolysis comprises a net REDOX reaction

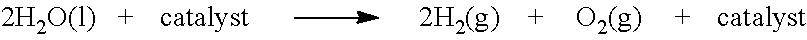

where the anode and cathode catalysts are ideally dissimilar.

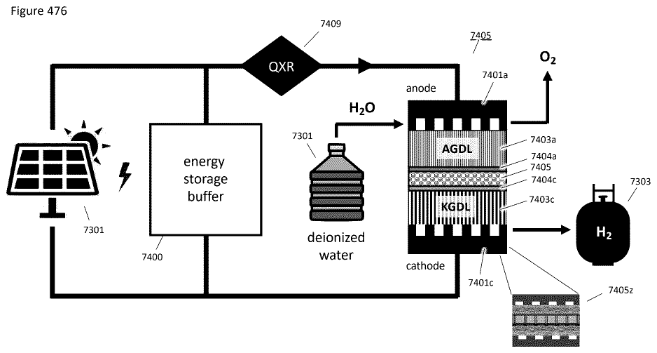

Because a hydrolyzer's hydrogen generation rate cannot be matched to its electrical input, it is important to temporarily store electric charge to continuously power the electrolysis process. As shown in FIG. 476, electric power input from a primary electric power source 7301 such as PV solar is stored in an energy storage buffer 7400. The stored charge is then released at a fixed current controlled by charge transfer regulator 7409 to power the ion exchange membrane 7405 converting deionized water 7301 into hydrogen 7303.

In the conversion process, the charge transfer regulator QXR performs two functions. First it ensures that the current delivered from the buffer array does not exceed a specified discharge rate to avoid damage to the electrochemical cell, for example 1 C. The programmability of the QXR 7409 also enables the maximum rate to be adjusted based on temperature or urgent demand. The second function is to control the current flow through the ion exchange membrane to prevent excessive current, over heating, or membrane damage.

In one embodiment the PEM+ membrane 7405z is adapted for use as the ion exchange membrane 7405 in the electrolyzer. Beneficial features of the PEM+ membrane in electrolysis includes
high conductivity bipolar plates 7401a and 7401c for reduced resistance, improved reaction uniformity, and higher conversion efficiencies;
graded gas diffusion layers AGDL 7403a and KGDL 7403c to improve water transport in the anode and hydrogen transport in the cathode leading to higher generation rates;
asymmetric catalyst layers comprising ACL 7304a cathode catalyst layers 7304c optimizing the reaction rates for the oxygen evolution reaction (OER) using the metallic oxides RuO₂ or IrO₂ and accelerating the hydrogen evolution reaction (HER) with transition metals Pt or Pd;
ion exchange membrane 7405 including an endoskeleton providing structural support allowing the membrane to be made thinner than conventional electrolysis membranes;
ion exchange membrane 7405 including sac pores generated using a sacrificial filler process improving membrane porosity; and
ion exchange membrane 7405 including permanent fillers and ionic liquids optionally contained by endoskeletal support and nanocoating layers.

Of particular significance is the role of the endoskeletal support grid enabling the IEM to be reduced from 100 μm to 20 μm, thereby profoundly affecting conductivity as was similarly demonstrated by the PEM+ membrane in fuel cell measurements.

Using conventional ion exchange membranes, each kilogram of hydrogen requires 55 kWh to generate 1 kg of hydrogen, and each kilogram of hydrogen can only generate 33 kWh of electrical energy, a n efficiency loss of 40% i.e. where ηWHHC=(33 kHh)/(55 kWh)=60%. As an embodiment of this invention, an improved ionomeric polymer is used to form the ion exchange membrane in a water to hydrogen electrolyzer to improve the overall conversion efficiency and hydrogen yield increasing conversion efficiency from 60% to 75%, reducing the power input required from 55 kWh to 44 kWh.

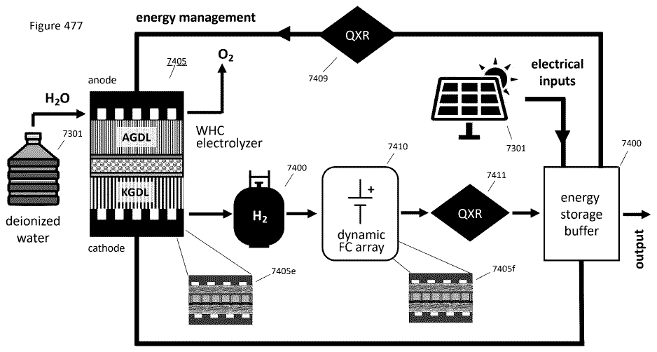

In an alternate system topology shown in FIG. 477, an integrated hydrogen energy system combines the iBFC dynamic μstack fuel cell array 7410 and water-to-hydrogen conversion (WHC) of electrolyzer 7410 together with a shared energy storage buffer 7400. As depicted, primary electrical power source 7301 such as a PV solar array inputs power directly into energy storage buffer which is used to power WHC electrolyzer 7410 to produce and store hydrogen 7400 from a source of deionized water 7301. The hydrogen in turn is used as fuel by dynamic fuel cell array 7410 to produce electric current to be stored in shared energy storage buffer 7400.

In the system shown, charge transfer regulator QXR 7411 controls the energy transfer rate from dynamic fuel cell array 7410 to energy storage buffer 7400 to prevent fuel cell voltage sag and overcharging or excessive charging currents in energy storage buffer 7400. A second charge transfer regulator QXR 7409 controls the flow of electric current from shared energy storage buffer 7400 into WHC electrolyzer 7410 to prevent excessive buffer currents and to protect the membrane in the hydrolyzer. Both dynamic fuel cell array 7410 comprising PEM+ membrane 7405f and WHC electrolyzer 7410 comprising PEM+ membrane 7405e benefit from the improved membrane features disclosed herein except that they include different catalyst layers. Together they improved the overall system efficiency in autonomous hydrogen energy systems, especially for powering multi user microgrids.

### Advanced IEM Features.

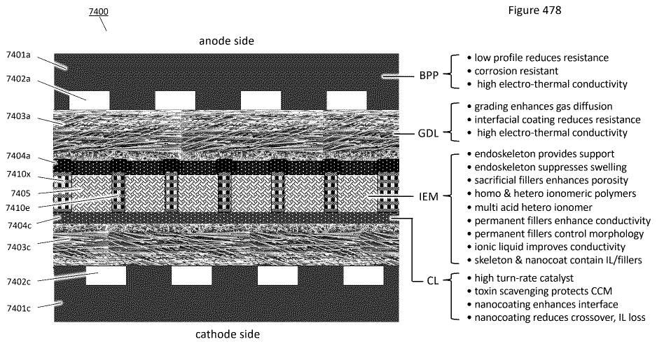

Features of the advanced membrane beneficial for both iBFC fuel cell conversion of hydrogen to electricity and as an electrolyte in electrolytic water-to-hydrogen conversion (W2HC) hydrolysis include a variety of creative embodiments which may be combined in various ways in inventive IEM 7400 as shown in FIG. 478. Beneficial embodiment of an advanced ion exchange membrane, either a PEM+ or AEM+ include the following structural elements:
BPP—Bipolar plates 7401a and 7401c with embedded gas channels 7402a and 7402c include a low profile thin carbon compound construction to reduce electrical resistance with corrosion resistant material construction, and superior electro-thermal conductivity;
hGDL—Heterogenous gas diffusion layers 7403a and 7403c comprise non-unform stepped or graded fiber length and pore size enhancing gas diffusion and providing balance between electrothermal conductivity and gas transport, which may include an interfacial coating reducing contact resistance between the GDL and the BPP, the catalyst layer, or both;
CL—Catalyst layers ACL 7404a and CCL 7404c include high turn-rate catalysts to maximize reaction rates, toxin scavengers such as MOFs to protect CCM, nanocoating enhancing interface charge and gas transport, and nanocoating to reduce fuel crossover and reduce diffusion of membrane toxins such as nitric oxide from damaging the CL and ionomers; and
IEM—Ion exchange membrane, either as PEM or AEM membrane comprise a mix of endoskeletal mechanical support for manufacturability and durability; endoskeletal support to suppress membrane swelling and humidity cycling failures; sacrificial fillers to enhance porosity and conductivity; homo & hetero ionomeric polymers to balance material strength vs electrical properties; multi-acid hetero-ionomers to expand an acid's range of operating conditions, permanent fillers such as metal oxides, nanoclusters, POSS, and MOFs to enhance membrane conductivity, reduce losses and minimize self heating; permanent fillers to control morphology and porosity; ionic liquids to improve conductivity; along with skeleton and nanocoating layers to contain fillers and ionic liquids within the membrane.

### Inventive Embodiments

Inventive elements of an improved ion exchange membrane (IEM) and its applications in energy conversion and electrochemistry include devices comprising enhanced ionomeric membranes and structures along with synthesis and fabrication processes therefore. Exemplary applications of the improved IEMs include their use in μstack fuel cells, intelligent buffered fuel cells (iBFCs), energy banks for individual residences and businesses; power blades for scalable autonomous power generation and microgrid distribution; water hydrolysis for hydrogen generation; and ionic filtering of fluids. Topics as disclosed, cover both apparatus and method subject matter.

### Electrochemical Membrane Innovations.

Improved ion exchange membranes (IEM) described herein include new and innovative ionomeric polymers [FIG. 430] comprising novel molecular matrices of homopolymers, cross-linked di-monomers, heteropolymers, intertwined heteropolymers [FIG. 429A], linear and multistrand copolymers [FIG. 429B], or block-polymers [FIG. 428A to FIG. 428L] of fluorocarbon and hydrocarbon compounds [FIG. 431A to FIG. 431R], structurally and chemically engineered to increase film conductivity, reinforce mechanical strength, enhance membrane durability and reliability, and improve manufacturing, reproducibility, and production yields. The improved ionomeric films are applicable for a variety of uses including proton exchange membranes fuel cells (PEMFCs), direct methanol fuel cells (DMFCs), anion exchange membrane fuel cells (AEMFCs), ionic filtering of air, water, wastewater, and for kidney electrodialysis.

Improved IEM fabrication using facile process methods include (i) controlling the relative ratio of hydrophobic-to-hydrophilic mainchain polymer segments; (ii) controlling the crystalline and amorphous structure of the polymer matrix through blending of monomers during polymerization; (iii) stoichiometrically adjusting the polymeric pore size and density of the polymer; (iv) controlling the length of sidechains with ionomeric termini including short sidechain (SSC), long sidechain (LSC), and multi-acid sidechain (MASC) pendants; and (v) enhancing conductivity over a wider ranges of temperature, humidity, and pH by integrating two-or-more acids into a hetero-ionomer. In another set of embodiments specific acids or acid-pairs are matched to the membrane polymer composition for compatibility, enhancing performance while preventing film degradation and fuel cell corrosion.

Alternative fabrication methods employ grafting sidechains with ionomer termini onto chemical or radiation-induced damage sites onto a polymer's mainchain, coating polymers with nanoparticles to form nano-entangled sidechain attachments to the polymer matrix, or embedding pristine or crushed electrospun nanofibers into the mold prior to polymerization.

In one set of embodiments, proton exchange membranes containing membrane bound acids that readily deprotonate into immobile anions, are paired to specific polymers with which they are most compatible. Membrane bound acids [FIG. 432A, FIG. 432B] made in accordance with this invention include sulfur-based sulphonic acid (HSO₃), sulfuric acid (H₂SO₄), sulfamic acid (H₃NSO₃), and sulfosuccinic acid (SSA); phosphorus-based phosphonic acid (H₃PO₃), phosphoric acid [H₂PO₄]-, and phosphotungstic acid (PWA); and hydrocarbon-based carboxylic acid (R—COOH), ethyl lactate (C₅H1₀O₃), citric acid (C₆H₈O₇), glycolic acid (C₂H₄O₃), butyric acid (C₃H₇COOH), pyruvic acid (C₂H₄O₃), acetic aid (AA); and hydrocarbon related compounds diethylphosphate (DEP), phenol hydroxide (Ph-OH), and amide groups (—CONH). Because of its strong acidity, trifluoromethanesulphonic acid aka triflate (TF) is limited in use to very low concentrations.

In another set of embodiments, mutually compatible acid pairs [FIG. 432C, FIG. 432D] are integrated into a membrane to expand the usable operating range [FIG. 432E] of the IEM including wider ranges of temperature, humidity, or pH. Exemplary acid pairs include sulfuric and sulfamic acid; sulphonic and phosphonic acid; sulphonic acid and phenol hydroxide; sulfosuccinic acid and sulphonic acid; pyruvic acid and butyric acid; diethylphosphate and dilute triflate; along with citric acid and acetic acid.

Aside from controlling the structure of ionomeric membranes during polymerization, other inventive embodiments include the addition of fillers [FIG. 429J, FIG. 429L] and dopants [FIG. 429M]. In one class of embodiments, a sacrificial filler such as sugar or cellulose is added to the mold prior to polymerization then dissolved and subsequently removed by a solvent such as water or ethanol after polymerization leaving well defined vacancies [FIG. 429I]. These vacancies form pores merging together into channels in the molecular matrix beneficially enhancing vehicular transport of hydronium ions without causing fuel crossover.

In conventional membrane synthesis, quasi-crystalline and amorphous polymer regions may spontaneously form during crosslinking adversely impacting pore formation and suppressing charge transport [FIG. 429G, FIG. 429H]. By contrast, the inventive sacrificial filler process offers precision control of film porosity whereby the average pore size and pore densities depend of the filler type and its molar concentration in the mold, not on the polymerization process conditions or monomer types employed. By independently controlling film porosity, improved IEM conduction properties includes better ion transport, higher energy conversion efficiency, reduced waste heat generation, and insensitivity to hydration levels. The inventive sacrificial filler process and resulting sac pores are therefore adaptable to any of the polymers described in this disclosure.

In another broad class of inventive embodiments, monomers used to form the improved ion exchange membranes are blended with permanent fillers [FIG. 429J] prior to molding. Unlike a sacrificial filler which is removed after polymerization, as the name suggests permanent fillers remain permanently in the matrix after polymerization. The effect of the fillers include beneficially improving carrier transport, conductivity, morphology, hydration, temperature dependence, and film strength. The permanent fillers also disrupt the periodicity of the polymer matrix as they compete for the same available volume [FIG. 428K].

Exemplary permanent fillers [FIG. 433A, FIG. 433B] include bismuth compounds (Bi-X); graphene oxide (GO); pristine and functionalized carbon nanotubes (CNTs); silicates (Si-X), zirconium (Zr-X), tungsten (W-X), zeolite, polyhedral silsesquioxanes (POSS, DDSQ), metal-organic frameworks (MOFs); and various nanostructures including nanoparticles (NPs), nanospheres (NS), nanoclusters (NCs), nanotubes (NTs), and electrospun nanofibers (NFs). While the addition of permanent fillers made in accordance with this invention requires blending the fillers with membrane monomers prior to polymerization, another form of membrane doping disclosed herein involves doping the membrane with ionic liquids after polymerization to increase its conductivity.

In one embodiment, after membrane polymerization, the polymer is soaked in an ionic liquid allowing mobile ions to seep into the natural interstitial pores and channels within polymeric matrix thereby enhancing electrical conductivity. The improvement however is mitigated by limitation if the naturally occurring density of membrane pockets and conduits not blocked by intervening atomic structure and ‘choke points’ impeding vehicular transport.

In an alternative embodiment, the polymer matrix is first fabricated using the sacrificial filler process where after polymerization the sacrificial filler is removed opening sac pores and channels. Thereafter the microporous membrane is soaked in ionic liquid whereby IL cations and anions pool within the pores [FIG. 429M]. Using sac pores, the IL concentration in the porous membrane is significantly higher than the peak IL concentration without employing the sacrificial filler process. As such the combination of sacrificial pores and ionic liquid doping [FIG. 429M] produces a far greater beneficial impact on membrane conductivity and fuel cell efficiency than simple IL doping.

As ionic liquids comprise organic ionic salts with low melting points, at fuel cell operating temperatures and even at room temperature the salts readily dissociate into liquids comprising mobile anions and cations. When introduced into an ionomeric membrane, these mobile charges aid in charge transport within the matrix via the film's dominant conduction mechanism. For example, mobile IL cations participate in conduction in a proton exchange membrane (PEM) while mobile IL anions contribute to charge transport in anion exchange membrane (AEM).

For example, embodiments of this invention include PEM dopants comprising the following IL cations [FIG. 433C]: imidazolium [Im]⁺, pyrrolidinium [Pyrr]⁺, pyridinium [Pyr]⁺, ammonium [NH₄]⁺, quaternary ammonium [NR₄]⁺, phosphonium [PR₄]⁺, sulfonium [SR₃]⁺, thiazolium [Thia]⁺, and piperidinium [Pipr]⁺. Other IL cations include protonated hydrocarbons such as carbonium aka alkanium [CₙH₂ₙ₊₃]⁺; biochemical cations including cholinium [ChoIH]⁺ and other protonated amino acids of creatine, arginine, lysine, and histidine. Other embodiments of cationic IL dopants include the superbase cations ammonium, phosphonium, sulfonium, phosphazene, amidine, guanidine, and other onium ions; and poly ionic liquids such as vinyl pyrrolidinium and poly N-vinylimidazolium Poly [nVIm]⁺.

Although performance improvements offered by innovative IEMs with micropores, skeletal support, and hetero-ionomers augmented by permanent fillers and dopants described herein represent generalized device concepts, their implementation is process dependent involving non-obvious combinations of monomers, reagents, cross-linkers, acids, dopants, and fillers varying with each class of polymer.

While detailed discussions are contained throughout this application as arranged by section representative samples of ionomeric polymer membranes are summarized here for convenience's sake. The table contains two classes of inventive embodiments—membranes and fillers. Membranes include PFSA homopolymer, composite reinforced PTFE-PFSA, amorphous glassy matrices, functionalized polyethylene (PE), polyvinyl alcohol (PVA), polyvinylidene fluoride (PVDF), polypropylene (PP), functionalized polyvinyl chloride (PVC), functionalized polyimide (PI), functionalized polystyrene (PS), poly(fluorenyl ether ketone nitrile (sPFEKN), polyphenylene (PPh), functionalized polyarylene ether (SPAE), polyarylene ether sulfone (SPAESf), functionalized poly ether ketones (PEK), functionalized poly ether sulfones (PESf), functionalized ketone sulfones (PKSf), functionalized arylene ether ketone sulfones (PAEKSf), perfluoro-methylene-methyl-dioxolane (PFMMD) or perfluoro-methylene-dimethyl-dioxolane (PFDD), poly-dioxo-dihydro-pyrrole copolymers (PDDP-co-X), phenyl copolymers (Ph-co-X) of alkane and aldehyde, polystyrene (PSt) and/or polyurethane (PTU), polysulfone (PSu, PSf), polyamide sulfonimide (SPA-co-Slm), phosphazene (Pz), siloxane (SiX), triazine (Tz), poly(methyl methacrylate) (PMMA), carboxymethyl cellulose (CMC), multi-acid sidechain (MASC), arylene ether polymer (PAE), acid-base polysulfone (PSf), anhydrous p-oxydiphenylene-bibenzimidazole](PBI), biopolymers including chitosan (CS), cellulose acetate (CA), alginic acid (AA), and polydopamine (PDA).

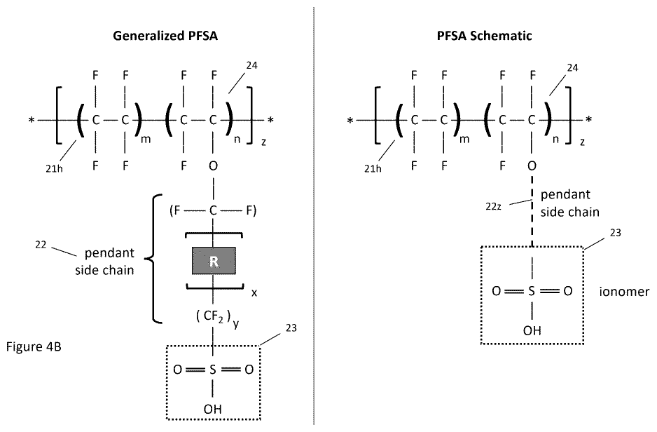

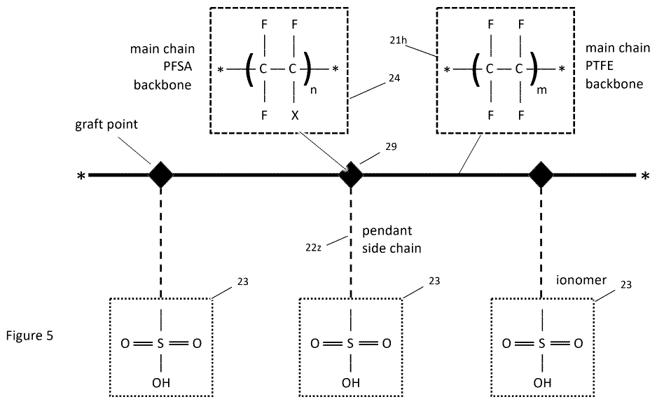

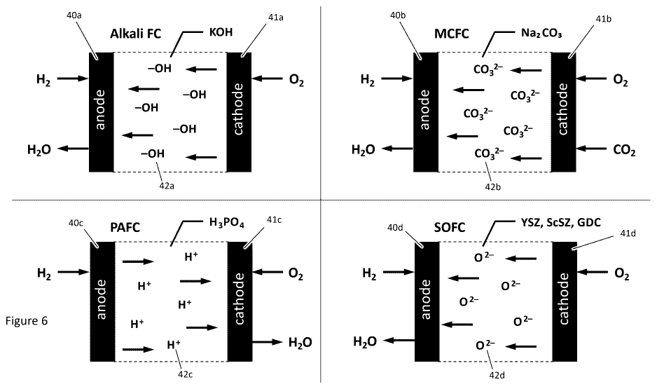

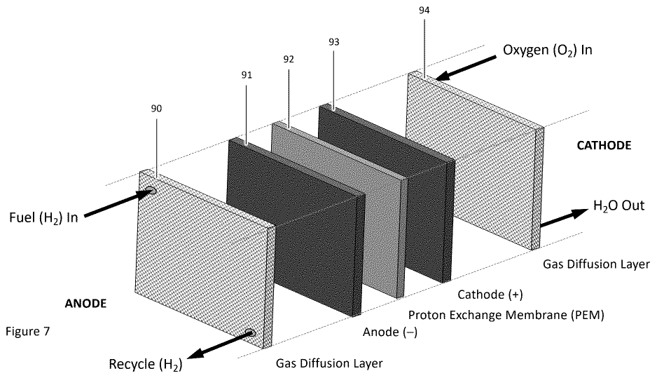

Permanent fillers and dopants include carbon fillers (GO, CNT), silicates, PMMA NS, polyhedral oligomeric silsesquioxanes compounds POSS and DDSQ, nanostructures including NSs, NCs, NFs, CNTs, and nanocoatings, zirconium (Zr) NS, MOFs, tungsten (W) NCs, zeolite (ZI), ionic liquids, and block copolymers.

| Independent Claims | Dependent Claim | Support |
|---|---|---|
| §1. A proton exchange membrane comprises a | the micropores are formed by sugar | FIGS. 4B, 18B, |
| PFSA homopolymer where | the skeleton comprises PTFE co- | 19A, 23, 24, |
| the membrane contains micropores formed | molded with or glued to the PFSA film | 77A, 77B, 81, |
| by a sacrificial filler process | optionally reinforced by rigid filler | 104 |
| the membrane contains skeletal support | one of the membrane bound acids | |
| the membrane contains at least two different | comprises phosphonic or sulfonic acid | |
| membrane bound acidic ionomers | the IEM is coated with PTFE NPs | |
| | the IEM includes permanent fillers | |
| | the IEM includes ionic liquids | |
| §2. A proton exchange membrane comprises a | the micropores are formed by sugar | FIGS. 23, 24, |
| composite PTFE-PFSA polymer where | the skeleton comprises PTFE co- | 77B, 81, 104, |
| the membrane contains micropores formed | molded with or glued to the PFSA film | 105, 106, 107 |
| by a sacrificial filler process | optionally reinforced by rigid filler | |
| the membrane contains skeletal support | one of the membrane bound acids | |
| the membrane contains at least two different | comprises phosphonic or sulfonic acid | |
| membrane bound acidic ionomers | the IEM is coated with PTFE NPs | |
| | the IEM includes permanent fillers | |
| | the IEM includes ionic liquids | |
| | the polymer mainchain is grafted or | |
| | entangled to a sidechain and ionomer | |
| §3. A proton exchange membrane comprises an | the micropores are formed by sugar | FIGS. 24, 77B, |
| amorphous glassy matrix such as PFMMD, PDD, | the skeleton comprises a quasi-rigid | 104, 110 |
| or sulfonated fluorocarbon glass where | polymer coated with PVA or adhesive | |
| the membrane contains micropores formed | one of the membrane bound acids | |
| by a sacrificial filler process | comprises phosphonic or sulfonic acid | |
| the membrane contains skeletal support | the IEM includes permanent fillers | |
| the membrane contains at least two different | the IEM includes ionic liquids | |
| membrane bound acidic ionomers | mobile IL cations are sequestered by | |
| | a nanocoating and endoskeleton | |
| §4. A proton exchange membrane comprises | the micropores are formed by sugar | FIGS. 24, 77B, |
| functionalized polyethylene (PE) where | the skeleton comprises a quasi-rigid | 104, 113 |
| the membrane contains micropores formed | polymer coated with PVA or adhesive | |
| by a sacrificial filler process | one of the membrane bound acids | |
| the membrane contains skeletal support | comprises phosphonic or sulfonic acid | |
| the membrane contains at least two different | the IEM includes permanent fillers | |
| membrane bound acidic ionomers | the IEM includes ionic liquids | |
| | mobile IL cations are sequestered by | |
| | a nanocoating and endoskeleton | |
| §5A. Proton exchange membrane comprises | the micropores are formed by sugar | FIGS. 24, 77B, |
| polyvinyl alcohol (PVA) grafted onto | the skeleton comprises a quasi-rigid | 104, 115 |
| functionalized cellulose acetate (CA) where | polymer coated with PVA or adhesive | |
| the membrane contains micropores formed | one of the membrane bound acids | |
| by a sacrificial filler process | comprises phosphonic or sulfonic acid | |
| the membrane contains skeletal support | the IEM includes permanent fillers | |
| the membrane contains at least two different | the IEM includes ionic liquids | |
| membrane bound acidic ionomers | mobile IL cations are sequestered by | |
| | a nanocoating and endoskeleton | |
| §5B. A proton exchange membrane comprises | the micropores are formed by sugar | FIGS. 24, 77B, |
| polyvinyl alcohol (PVA) where | the skeleton comprises a quasi-rigid | 104, 117 |
| the membrane contains micropores formed | polymer coated with PVA or adhesive | |
| by a sacrificial filler process | one of the membrane bound acids | |
| the membrane contains skeletal support | comprises phosphonic, sulfonic, or | |
| the membrane contains at least two different | sulfosuccinic acid (SSA) | |
| membrane bound acidic ionomers | SSA forms a cross link between at | |
| | least two PVA mainchains | |
| | the IEM includes permanent fillers | |
| | the IEM includes ionic liquids | |
| | mobile IL cations are sequestered by | |
| | a nanocoating and endoskeleton | |
| §6. A proton exchange membrane comprises | the copolymer is PVP-PSSA | FIGS. 24, 77B, |
| copolymers or blends of polyvinylidene fluoride | the copolymer is PMMA | 104, 118-123, |
| (PVDF) with other polymers where | the copolymer is PC | 124 |
| the membrane contains micropores formed | the copolymer is PFSA | |
| by a sacrificial filler process | the copolymer is PVP-SA | |
| the membrane contains skeletal support | the copolymer is AIBN-SPA | |
| the membrane contains at least two different | the copolymer is AIBN-SPA-PFH | |
| membrane bound acidic ionomers | the copolymer is HFP | |
| | the micropores are formed by sugar | |
| | the skeleton comprises a quasi-rigid | |
| | polymer coated with PVA or adhesive | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §7. A proton exchange membrane comprising | the copolymer is PFSA | FIGS. 24, 77B, |
| polypropylene (PP) blended with other | the micropores are formed by sugar | 104, 118-123, |
| polymers where | the skeleton comprises a quasi-rigid | 126 |
| the membrane contains micropores formed | polymer coated with PVA or adhesive | |
| by a sacrificial filler process | one of the membrane bound acids | |
| the membrane contains skeletal support | comprises phosphonic or sulfonic acid | |
| the membrane contains at least two different | the IEM includes permanent fillers | |
| membrane bound acidic ionomers | the IEM includes ionic liquids | |
| | mobile IL cations are sequestered by | |
| | a nanocoating and endoskeleton | |
| §8. A proton exchange membrane comprises | the micropores are formed by sugar | FIGS. 24, 77B, |
| functionalized polyvinyl chloride (PVC) where | the skeleton comprises a quasi-rigid | 104, 128 |
| the membrane contains micropores formed | polymer coated with PVA or adhesive | |
| by a sacrificial filler process | one of the membrane bound acids | |
| the membrane contains skeletal support | comprises sulfuric or sulfonic acid | |
| the membrane contains at least two different | the IEM includes permanent fillers | |
| membrane bound acidic ionomers | the IEM includes ionic liquids | |
| | mobile IL cations are sequestered by | |
| | a nanocoating and endoskeleton | |
| §9. A proton exchange membrane comprises | the PI chain includes sulfonamides | FIGS. 24, 77B, |
| functionalized polyimide (PI) where | such as ODADS and PBABTS | 104, 129-131, |
| the membrane contains micropores formed | the PI chain includes diamines such | 132 |
| by a sacrificial filler process | as BAPP, 9FDA, BAPN | |
| the membrane contains skeletal support | the PI chain includes dianhydrides | |
| the membrane contains at least two different | such as BPADA, NTDA, ODPA, DSDA | |
| membrane bound acidic ionomers | the micropores are formed by sugar | |
| | the skeleton comprises a quasi-rigid | |
| | polymer coated with PVA | |
| | one of the membrane bound acids | |
| | comprises sulfuric or sulfonic acid | |
| | the IEM includes permanent fillers | |
| | the IEM includes ionic liquids | |
| | mobile IL cations are sequestered by | |
| | a nanocoating and endoskeleton | |
| §10. A proton exchange membrane comprises | the micropores are formed by sugar | FIGS. 24, 77B, |
| functionalized polystyrene (PS) where | the skeleton comprises a quasi-rigid | 104, 136 |
| the membrane contains micropores formed | polymer coated with PVA or adhesive | |
| by a sacrificial filler process | one of the membrane bound acids | |
| the membrane contains skeletal support | comprises phosphonic or sulfonic acid | |
| the membrane contains at least two different | the IEM includes permanent fillers | |
| membrane bound acidic ionomers | the IEM includes ionic liquids | |
| | mobile IL cations are sequestered by | |
| | a nanocoating and endoskeleton | |
| §11. A proton exchange membrane comprises | the micropores are formed by sugar | FIGS. 24, 77B, |
| poly(fluorenyl ether ketone nitrile (sPFEKN) | the skeleton comprises a quasi-rigid | 104, 138 |
| where | polymer coated with PVA or adhesive | |
| the membrane contains micropores formed | one of the membrane bound acids | |
| by a sacrificial filler process | comprises phosphonic or sulfonic acid | |
| the membrane contains skeletal support | the IEM includes permanent fillers | |
| the membrane contains at least two different | the IEM includes ionic liquids | |
| membrane bound acidic ionomers | mobile IL cations are sequestered by | |
| | a nanocoating and endoskeleton | |
| §12. A proton exchange membrane comprises | PPh variants include sPP, sPP-QA, | FIGS. 24, 77B, |
| functionalized polyphenylene (PPh) where | sPPP-H⁺, sPPN-H⁺, sPPB-H⁺, sPPT-H⁺, | 104, 153 |
| the membrane contains micropores formed | sPPBm-H⁺, sPPBo-H⁺, sPPP-OH, sPPP | |
| by a sacrificial filler process | N-free, sPPP(X + 0)N, sPPP(X + 1)N | |
| the membrane contains skeletal support | PP also comprise PPDSA, PBPDSA, | |
| the membrane contains at least two different | BXPY, DiBPS, DiiPS, DiBtBS, Si-PPBP | |
| membrane bound acidic ionomers | the micropores are formed by sugar | |
| | the skeleton comprises a quasi-rigid | |
| | polymer coated with PVA or adhesive | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §13. A proton exchange membrane comprises | the micropores are formed by sugar | FIGS. 24, 77B, |
| functionalized polyarylene ether (SPAE) and | the skeleton comprises a quasi-rigid | 104, 154-158, |
| polyarylene ether sulfone (SPAESf) where | polymer coated with PVA or adhesive | 159 |
| the membrane contains micropores formed | one of the membrane bound acids | |
| by a sacrificial filler process | comprises phosphonic or sulfonic acid | |
| the membrane contains skeletal support | the IEM includes permanent fillers | |
| the membrane contains at least two different | including Krytox ®-157 FSL GO, PFPE- | |
| membrane bound acidic ionomers | GO, and PWA crystallites | |
| | the IEM includes ionic liquids | |
| | mobile IL cations are sequestered by | |
| | a nanocoating and endoskeleton | |
| §14. A proton exchange membrane comprises | poly ether ketones include sPEEK, | FIGS. 24, 77B, |
| functionalized poly ether ketones (PEK) where | sPEK, sPEKK, sPEEEK, sPEEKK, | 104, 160-169, |
| the membrane contains micropores formed | sPEKKK, sPEKEKK, 2PEK | 170 |
| by a sacrificial filler process | the micropores are formed by sugar | |
| the membrane contains skeletal support | the skeleton comprises a quasi-rigid | |
| the membrane contains at least two different | polymer coated with PVA or adhesive | |
| membrane bound acidic ionomers | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §15A. A proton exchange membrane comprises | poly ether sulfones include R-PEESf, | FIGS. 24, 77B, |
| functionalized poly ether sulfones (PESf) | sPEESf, sPESfESf, sPESf | 104, 171-179, |
| polymers and copolymers where | poly ether sulfones copolymers | 180 |
| the membrane contains micropores formed | include sPEESf-co-PEI, sP(PhEESf)- | |
| by a sacrificial filler process | PAMPS | |
| the membrane contains skeletal support | poly ether sulfone variants include | |
| the membrane contains at least two different | sPEDSf, sFPESf, sP(PhESf) | |
| membrane bound acidic ionomers | radicals R may be H+, SO₃H, SO₃Na . . . | |
| | the micropores are formed by sugar | |
| | the skeleton comprises a quasi-rigid | |
| | polymer coated with PVA or adhesive | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §15B. A proton exchange membrane comprises | ketone sulfones include sPKKSf | FIGS. 24, 77B, |
| functionalized ketone sulfones (PKSf), arylene | arylene ether ketone sulfones | 104, 181A- |
| ether ketone sulfones (PAEKSf), and variants | include sPAKEKSf, sPAKEKSf, sPAEKSf | 185, 186 |
| therefrom where | the micropores are formed by sugar | |
| the membrane contains micropores formed | the skeleton comprises a quasi-rigid | |
| by a sacrificial filler process | polymer coated with PVA or adhesive | |
| the membrane contains skeletal support | one of the membrane bound acids | |
| the membrane contains at least two different | comprises phosphonic or sulfonic acid | |
| membrane bound acidic ionomers | the IEM includes permanent fillers | |
| | fillers include bismuth compounds of | |
| | BiTMA and Bᵢ₂MoO₆ | |
| | the IEM includes ionic liquids | |
| | mobile IL cations are sequestered by | |
| | a nanocoating and endoskeleton | |
| §16. A hybrid proton exchange membrane | ionomeric membranes may include | FIGS. 24, 77B, |
| containing permanent fillers of carbon | PFSA, PFSA-PTFE, SPAESf, SPEEK, PVA, | 104, 187-195, |
| compounds and nanostructures applicable for a | PBI, PI, and CS | 196 |
| range of fluorocarbon and hydrocarbon | pristine carbon nanotubes including | |
| polymer chemistries | SW-CNT, MW-CNT | |
| | CNTs functionalized by COOH, SO3H, | |
| | POH, —NH₂, SiO₂, and TiO₂ | |
| | graphene oxides (GO) functionalized | |
| | by Krytox ®-157 FS, PFPE, and ABPBI | |
| | GO variants include Hohman, Scholz- | |
| | Boehn, Ruess, and Lerf-Klinowski | |
| §17. A hybrid proton exchange membrane | ionomeric membranes may include | FIGS. 24, 77B, |
| contains permanent fillers of silica | PFSA, PFSA-PTFE, SPAESf, SPEEK, PVA, | 104, 197-204, |
| | PBI, PI, and CS | 205 |
| | inert silicates controlling density | |
| | silica mesostructured cellular foam | |
| | functionalized hollow MCF PA,SA,OH | |
| | Al-MCF mPBI hybrid membrane | |
| §18. A hybrid proton exchange membrane | copolymers include P(PFMMD-co- | FIGS. 24, 77B, |
| comprises functionalized perfluoro-methylene- | PFMD), P(PFMDD-co-PFMD), | 104, 206A- |
| methyl-dioxolane (PFMMD) or perfluoro- | P(PFMMD-co-CTFE), P(PFMDD-co- | 211F, 212 |
| methylene-dimethyl-dioxolane (PFDD) | CTFE), P(PFMMD-co-PFSt), and | |
| polymers and copolymers where | PFMMD-co-PFSA | |
| the membrane contains micropores formed | tri-copolymers include P(PFMMD-co- | |
| by a sacrificial filler process | PFMD-co-PFSA), P(PFMDD-co-PFMD- | |
| the membrane contains skeletal support | co-PFSA), P(PFMMD-co-CTFE-co- | |
| the membrane contains at least two different | PFSA), P(PFMMD-co-CTFE-co-PFSA), | |
| membrane bound acidic ionomers | P(PFMMD-co-PFSt-co-PFSA), and | |
| | P(PFMMD-co-PFSt-co-PFSA) | |
| | the micropores are formed by sugar | |
| | the skeleton comprises a quasi-rigid | |
| | polymer coated with PVA or adhesive | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §19. A hybrid proton exchange membrane | PDDP copolymers include PDDP- | FIGS. 24, 77B, |
| comprises poly-dioxo-dihydro-pyrrole | CSFS, SPmax-1200, PDDP-CSFSt-co- | 104, 213- |
| copolymers (PDDP-co-X) where | SPmax, PDDP-CSFSt-co-SPmax, | 215B, 216 |
| the membrane contains micropores formed | the micropores are formed by sugar | |
| by a sacrificial filler process | the skeleton comprises a quasi-rigid | |
| the membrane contains skeletal support | polymer coated with PVA or adhesive | |
| the membrane contains at least two different | one of the membrane bound acids | |
| membrane bound acidic ionomers | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §20. A hybrid proton exchange membrane | phenyl copolymers comprise | FIGS. 24, 77B, |
| comprises phenyl copolymers (Ph-co-X) of | sulfonated phenyl-co-alkane (SP3) and | 104, 217-221, |
| alkane and aldehyde where | phenyl-co-alkane (sPhCH = O) | 222 |
| the membrane contains micropores formed | the micropores are formed by sugar | |
| by a sacrificial filler process | the skeleton comprises a quasi-rigid | |
| the membrane contains skeletal support | polymer coated with PVA or adhesive | |
| the membrane contains at least two different | one of the membrane bound acids | |
| membrane bound acidic ionomers | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §21. A hybrid proton exchange membrane | styrene polymers include | FIGS. 24, 77B, |
| comprises polystyrene (PSt) and/or | poly(trifluorostyrene) (sPTFS) | 104, 223-227, |
| polyurethane (PTU) polymers and copolymers | styrene cross links and grafts include | 228 |
| including grafts and cross-links where | sPTFS-XL-sPTFS and P(PFA)-g-PSSA | |
| the membrane contains micropores formed | styrene and urethane copolymers | |
| by a sacrificial filler process | include PS-co-sPSS, PTPU-co-sDVB | |
| the membrane contains skeletal support | styrene-urethane copolymers | |
| the membrane contains at least two different | include PTPU-co-PSS-co-sDVB, PTPU- | |
| membrane bound acidic ionomers | co-PUE-co-DVB-co-PSS | |
| | the micropores are formed by sugar | |
| | the skeleton comprises a quasi-rigid | |
| | polymer coated with PVA or adhesive | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §22. A hybrid proton exchange membrane | polysulfone includes (sPSf, sPSU) | FIGS. 24, 77B, |
| comprises polysulfone (PSu, PSf) polymer | the micropores are formed by sugar | 104, 229-230, |
| where | the skeleton comprises a quasi-rigid | 231 |
| the membrane contains micropores formed | polymer coated with PVA or adhesive | |
| by a sacrificial filler process | one of the membrane bound acids | |
| the membrane contains skeletal support | comprises phosphonic or sulfonic acid | |
| the membrane contains at least two different | the IEM includes permanent fillers | |
| membrane bound acidic ionomers | the IEM includes ionic liquids | |
| | mobile IL cations are sequestered by | |
| | a nanocoating and endoskeleton | |
| §23. A hybrid proton exchange membrane | sulfonimide includes SPA-co-SIm and | FIGS. 24, 77B, |
| comprises a polyamide sulfonimide (SPA-co- | sSPA-co-SIm | 104, 232- |
| Slm) polymer where | the micropores are formed by sugar | 233B, 234 |
| the membrane contains micropores formed | the skeleton comprises a quasi-rigid | |
| by a sacrificial filler process | polymer coated with PVA or adhesive | |
| the membrane contains skeletal support | one of the membrane bound acids | |
| the membrane contains at least two different | comprises phosphonic or sulfonic acid | |
| membrane bound acidic ionomers | the IEM includes permanent fillers | |
| | the IEM includes ionic liquids | |
| | mobile IL cations are sequestered by | |
| | a nanocoating and endoskeleton | |
| §24. A hybrid proton exchange membrane | phosphazene include P(sPz), P(sPz- | FIGS. 24, 77B, |
| comprises a phosphazene (Pz) polymer where | co-Pz), or P(pPz-co-Pz) | 104, 235A- |
| the membrane contains micropores formed | the micropores are formed by sugar | 235B, 236 |
| by a sacrificial filler process | the skeleton comprises a quasi-rigid | |
| the membrane contains skeletal support | polymer coated with PVA or adhesive | |
| the membrane contains at least two different | one of the membrane bound acids | |
| membrane bound acidic ionomers | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §25. A hybrid proton exchange membrane | siloxane includes P(sSiX-co-SiX) | FIGS. 24, 77B, |
| comprises a siloxane (SiX) polymer where | the micropores are formed by sugar | 104, 237, 238 |
| the membrane contains micropores formed | the skeleton comprises a quasi-rigid | |
| by a sacrificial filler process | polymer coated with PVA or adhesive | |
| the membrane contains skeletal support | one of the membrane bound acids | |
| the membrane contains at least two different | comprises phosphonic or sulfonic acid | |
| membrane bound acidic ionomers | the IEM includes permanent fillers | |
| | the IEM includes ionic liquids | |
| | mobile IL cations are sequestered by | |
| | a nanocoating and endoskeleton | |
| §26. A hybrid proton exchange membrane | triazine polymers include pCTF, | FIGS. 24, 77B, |
| comprises a triazine (Tz) polymer or copolymer | sCTP, pCTF-sPh, pCTF-pTPA, pCTF- | 104, 240-245, |
| where | sTPhA, pCTF-TF | 246 |
| the membrane contains micropores formed | copolymers include sCTF-co-PVDF, | |
| by a sacrificial filler process | P(SPAESf-co-TBPh) | |
| the membrane contains skeletal support | functionalized triazine frameworks | |
| the membrane contains at least two different | include 6T6sPh, 3T6sPh, 6T12sPh6bPy, | |
| membrane bound acidic ionomers | and 6T6Ph-F₄ | |
| | the micropores are formed by sugar | |
| | the skeleton comprises a quasi-rigid | |
| | polymer coated with PVA or adhesive | |
| | one of the membrane bound acids | |
| | comprises phosphonic or sulfonic acid | |
| | the IEM includes permanent fillers | |
| | SA or PA functionalized triazine | |
| | substrate as a permanent filler | |
| | the IEM includes ionic liquids | |
| | mobile IL cations are sequestered by | |
| | a nanocoating and endoskeleton | |
| §27. A hybrid proton exchange membrane of | PMMA copolymers include sP(MMA- | FIGS. 24, 77B, |
| nanospheres comprise a poly(methyl | co-MAH), sP(MMA-co-MAH-co-Mi) | 104, 247A- |
| methacrylate) (PMMA) polymer where | PMMA grafted IEMs including PE-g- | 261, 262 |
| the membrane contains micropores formed | PMMA, PMMA-g-PVDC | |
| by a sacrificial filler process | the micropores are formed by sugar | |
| the membrane contains skeletal support | the skeleton comprises a quasi-rigid | |
| the membrane contains at least two different | polymer coated with PVA or adhesive | |
| membrane bound acidic ionomers | one of the membrane bound acids | |
| | comprises phosphonic or sulfonic acid | |
| | the IEM includes permanent fillers | |
| | SPMMA and porous PMMA | |
| | nanospheres | |
| | PMMA-nanoclusters including Pd | |
| | PMMA NCs, Pd MMA-MAA NCs, ZnS | |
| | NS doped NCs, ZnO NS doped NCs, | |
| | the IEM includes ionic liquids | |
| | mobile IL cations are sequestered by | |
| | a nanocoating and endoskeleton | |
| §28. A hybrid proton exchange membrane | copolymers include CMC-co-PVA-co- | FIGS. 24, 77B, |
| comprises carboxymethyl cellulose (CMC) | AA | 104, 263 |
| copolymers where | the micropores are formed by sugar | |
| the membrane contains micropores formed | the skeleton comprises a quasi-rigid | |
| by a sacrificial filler process | polymer coated with PVA or adhesive | |
| the membrane contains skeletal support | one of the membrane bound acids | |
| the membrane contains at least two different | comprises phosphonic or sulfonic acid | |
| membrane bound acidic ionomers | the IEM includes permanent fillers | |
| | the IEM includes ionic liquids | |
| | mobile IL cations are sequestered by | |
| | a nanocoating and endoskeleton | |
| §29. A hybrid proton exchange membrane | multi acid sidechains include PFIA | FIGS. 24, 77B, |
| comprises a multi-acid sidechain (MASC) | the micropores are formed by sugar | 104, 264- |
| polymer where | the skeleton comprises a quasi-rigid | 265C, 266 |
| the membrane contains micropores formed | polymer coated with PVA or adhesive | |
| by a sacrificial filler process | one of the membrane bound acids | |
| the membrane contains skeletal support | comprises phosphonic or sulfonic acid | |
| the membrane contains at least two different | the IEM includes permanent fillers | |
| membrane bound acidic ionomers | the IEM includes ionic liquids | |
| | mobile IL cations are sequestered by | |
| | a nanocoating and endoskeleton | |
| §30. A hybrid proton exchange membrane | poly arylene ether moieties include | FIGS. 24, 77B, |
| comprises arylene ether polymer (PAE) where | P12F9-7B, sP6F9-CB | 104, 267-269, |
| the membrane contains micropores formed | the micropores are formed by sugar | 270 |
| by a sacrificial filler process | the skeleton comprises a quasi-rigid | |
| the membrane contains skeletal support | polymer coated with PVA or adhesive | |
| the membrane contains at least two different | one of the membrane bound acids | |
| membrane bound acidic ionomers | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §31 A hybrid proton exchange membrane | ionomeric membranes may include | FIGS. 24, 77B, |
| containing permanent fillers of polyhedral | PFSA, PFSA-PTFE, SPAESf, SPEEK, PVA, | 104, 271- |
| oligomeric silsesquioxanes compounds POSS | PBI, PI, and CS | |
| and DDSQ and nanostructures thereof | polyoctahedral SQ compounds | |
| applicable for a wide range of fluorocarbon | include POSS-SH, POSS-S-PA, POSS-R, | |
| and hydrocarbon polymer chemistries | POSS-PEG-R, POSS-iBu, POSS-Vi, POSS- | |
| | 8CI, Ot-POSS, OV-POSS, OPh-POSS, | |
| | POSS-iBu-Vi, POSS-iBu-NH₂, POSS-Bu- | |
| | CI, POSS-iBu-3OH, POSS-iBu-styryl, | |
| | POSS-iBu-PS, POSS-PS-R, sPOSS-Cp-PS, | |
| | sPOSS-Cy-PS, POSS-AM-iBu, POSS-SH- | |
| | iBu, POSS-A, POSS resin-cage | |
| | polyoctahedral SQ compounds | |
| | include unreactive POSS, 1D POSS, | |
| | planar POSS, and 3D POSS | |
| | double-decker SQ compounds | |
| | include DDSQ, NMe DDSQ-R, and Me | |
| | DDSQ-R | |
| §32 A hybrid proton exchange membrane | hybrid membranes include s(PVA-co- | FIGS. 24, 77B, |
| containing permanent fillers of nanostructures | SPA-co-PEO) with PO₄TiO₂ CNT fillers | 104, 293- |
| applicable for a range of fluorocarbon and | hybrid membranes of PFSA-PTFE | 296B, 307 |
| hydrocarbon polymer chemistries | with P(DA-sDA) | |
| | hybrid membrane comprising sol-gel | |
| | matrix with scavenger NP and catalyst | |
| | ionomeric membranes may include | |
| | PFSA, PFSA-PTFE, SPAESf, SPEEK, PVA, | |
| | PBI, PI, and CS | |
| | nanocoatings include polyimide (PI) | |
| | atop PTFE-PFSA membrane | |
| | nanocomposites include PTFE-PFSA | |
| | nanofiber pristine extended PTFE | |
| | nanofibers include dopamine and | |
| | zirconium nanocoated ePTFE, DPA and | |
| | Pt nanocoated polyimide | |
| | carbon nanotubes include CNTs | |
| | coated by PBI, functionalized by | |
| | (PtCl₆)⁻², NH₂, Pt-NH₂ NPs, Ti-NH₂ NPs, | |
| | Pt-Sn NPs | |
| | electrospun nanofibers (NFs) of poly | |
| | sulfonated polystyrene | |
| §33 A hybrid proton exchange membrane | ionomeric membranes may include | FIGS. 24, 77B, |
| containing permanent fillers of zirconium (Zr) | PFSA, PFSA-PTFE, SPAESf, SPEEK, PVA, | 104, 308-311, |
| compounds and nanostructures applicable for a | PBI, PI, and CS | 312 |
| range of fluorocarbon and hydrocarbon | polyether sulfone membrane | |
| polymer chemistries | includes intercalant zirconium (α-type, | |
| | λ-type, and γ-type) | |
| | zirconium nanospheres | |
| §34 A hybrid proton exchange membrane | ionomeric membranes may include | FIGS. 24, 77B, |
| containing permanent fillers of metal organic | PFSA, PFSA-PTFE, SPAESf, SPEEK, PVA, | 104, 313- |
| frameworks (MOFs) and nanostructures | PBI, PI, and CS | 333B, 334 |
| applicable for a range of fluorocarbon and | MOFs comprise convex, concave, | |
| hydrocarbon polymer chemistries | cluster, rectangular prism, cube, | |
| | trapezoid, double trapezoid, | |
| | hexagonal drum, octagonal drum | |
| | geometries with or without guests | |
| | MOFs include 3D quasi crystals, acid | |
| | pendants, with acid-to-acid and quasi- | |
| | crystal bonding | |
| | MOFs include metal clusters of zinc | |
| | acetate, zirconium hydroxide, sulfonic | |
| | ferrite, chromium terephthalate, and | |
| | zinc oxide | |
| | scavenger MOFs include MOF | |
| | vertex, ligand, guest, or interleaved | |
| | scavengers | |
| | metal-ligand-heterometals include | |
| | Fe-Pt, Fe-Ti, Co-Pt, and Ni-Pt systems | |
| | M-L-M bonds include M-dithiolene, | |
| | M-EDT, M-PLTSC, M-ambidentate, M- | |
| | DPPE, M-BIPY, M-salicylaldehyde, and | |
| | M-Schiff base | |
| §35 A hybrid proton exchange membrane | ionomeric membranes may include | FIGS. 24, 77B, |
| containing permanent fillers of tungsten (W) | PFSA, PFSA-PTFE, SPAESf, SPEEK, PVA, | 104, 335-339, |
| compounds and nanostructures applicable for a | PBI, PI, and CS | 340 |
| wide range of fluorocarbon and hydrocarbon | PSf membrane includes PWA, P4VP, | |
| polymer chemistries | CP4VP | |
| | PVA membranes includes PWA, | |
| | QPEI, and R₄N⁺ | |
| | IEM dopants include WC NPs, PWA | |
| | phosphotungstic acid | |
| §36 A hybrid proton exchange membrane | ionomeric membranes may include | FIGS. 24, 77B, |
| containing permanent fillers of zeolite (ZI) | PFSA, PFSA-PTFE, SPAESf, SPEEK, PVA, | 104, 341-349, |
| compounds and nanostructures applicable for a | PBI, PI, and CS | 350 |
| range of fluorocarbon and hydrocarbon | functionalized zeolites (Al₂O₃)⁻ | |
| polymer chemistries | (SiO₂)ₓ includes phenylsulfuric acid | |
| | zeolite (PhSA-Zl) | |
| | zeolite geometries include L, LTA/A, | |
| | X&Y, ZSM-5, pentasil MOR, pentasil | |
| | FOR, pentasil BEA, and s-mordenite | |
| | zeolite NC includes metal catalyst | |
| §37. A hybrid proton exchange membrane | functionalized polysulfone includes | FIGS. 24, 77B, |
| comprises an acid-base polysulfone (PSf) | sPSf, BrPSf, (BrPSf)x | 104, 351-361, |
| polymers where | functionalized graphene oxide | 362 |
| the membrane contains micropores formed | doped polysulfone (FPGO-sPSf) | |
| by a sacrificial filler process | the micropores are formed by sugar | |
| the membrane contains skeletal support | the skeleton comprises a quasi-rigid | |
| the membrane contains at least two different | polymer coated with PVA or adhesive | |
| membrane bound acidic ionomers | one of the membrane bound acids | |
| | comprises phosphonic or sulfonic acid | |
| | the IEM includes permanent fillers | |
| | Pt-TiO₂ nanoparticle filler | |
| | polyoctahedral silsesquioxanes | |
| | (POSS) filler | |
| | the IEM includes ionic liquids | |
| | mobile IL cations are sequestered by | |
| | a nanocoating and endoskeleton | |
| §38. A hybrid proton exchange membrane | PBI variants include O-PBI, 2O-PBI | FIGS. 24, 77B, |
| comprises anhydrous p-oxydiphenylene- | PAEBI, ABPBI, 20H-PBI, F₆-PBI, SO₂- | 104, 363-378, |
| bibenzimidazole] (PBI) polymer where | PBI, SC-SO₂-PBI | 379 |
| the membrane contains micropores formed | copolymers include HCCP-co-PBI, | |
| by a sacrificial filler process | ImCCP-co-PBI, OPBI-co-PVBC, DABCO- | |
| the membrane contains skeletal support | co-OPBI-co-PVBC-co-quinuclidine, | |
| the membrane contains at least two different | OPBI-co-QA, PBI-co-ZIF | |
| membrane bound acidic ionomers | includes crushed electrospun fibers | |
| | the micropores are formed by sugar | |
| | the skeleton comprises a quasi-rigid | |
| | polymer coated with PVA or adhesive | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §39. A hybrid proton exchange membrane | biopolymers comprise functionalized | FIGS. 24, 77B, |
| comprises a biopolymers where | chitosan (CS), cellulose (CE), alginic | 104, 380- |
| the membrane contains micropores formed | acid (AA), phosphorylated chitosan | 401D, 402 |
| by a sacrificial filler process | (pCS), chitosan sulfonate (sCS), XL | |
| the membrane contains skeletal support | sulfonated chitosan (sCS), cellulose | |
| the membrane contains at least two different | acetate (CA), polydopamine (PDA), | |
| membrane bound acidic ionomers | CS-co-PEO, fCS-co-PEO | |
| | bio-copolymers (CS-co-PAN)-R, (CS- | |
| | co-PS)-R, (CS-co-PVA)-R, CS-co-PFSA, | |
| | grafted biopolymers CS-g-PVP, CS-g- | |
| | SSA, sCA-g-P(MMA-co-AMPS), spCA-g- | |
| | P(MMA-co-AMPS) | |
| | carbon functionalized chitosan CS-g- | |
| | PVP-CNT, CS-g-sGO | |
| | polyhedral oligomeric SQ doped | |
| | chitosan (POSS XL-CS) | |
| | polydopamine copolymer PDA-co- | |
| | ADPS-SA, sCS-co-PDA-co-ADPS-SA, CS- | |
| | co-PDA, CS-co-fPDA | |
| | the micropores are formed by sugar | |
| | the skeleton comprises a quasi-rigid | |
| | polymer coated with PVA | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |
| §40. A hybrid proton exchange membrane | ionomeric membranes may include | FIGS. 24, 77B, |
| containing permanent fillers of ionic liquid | PFSA, PFSA-PTFE, SPAESf, SPEEK, PVA, | 104, 403A- |
| compounds and nanostructures applicable for a | PBI, PI, and CS | 421422A-423, |
| diverse range of fluorocarbon and hydrocarbon | mobile cations include imidazolium | 424 |
| polymer chemistries | [Im]⁺, pyrrolidinium [Pyrr]⁺, pyridinium | |
| | [Pyr]⁺, ammonium [NH₄]⁺, quaternary | |
| | ammonium [NR₄]⁺, sulfonium [SR₃]⁺, | |
| | thiazolium [Thia]⁺, piperidinium [Pipr]⁺; | |
| | phosphonium [PR₄]⁺, protonated HC | |
| | alkanium [CₙH₂ₙ₊₃]⁺; biochemical | |
| | cations e.g. cholinium [CholH]⁺ | |
| | mobile anions hexafluorophosphate | |
| | [−PF₆]⁻; nitrate [−NO₃]⁻ ; triflate | |
| | [−OTf]⁻; tetrafluoroborate [−BF₄] ; | |
| | trifluoromethylacetate [−TFA]⁻ | |
| | forming ILs via metal metathesis | |
| | reaction or acid-base neutralization | |
| | reaction, | |
| | sequestering IL by endoskeletons | |
| | and nanocoating | |
| | pooling IL ions in sac pores | |
| §41. A hybrid proton exchange membrane | polymer blocks sequenced by | FIGS. 24, 77B, |
| comprises a block copolymers including where | excision-insertion reactions (EIR), | 104, 426-428L |
| the membrane contains micropores formed | modified ring opening polymerization | |
| by a sacrificial filler process | (MROP), nucleophilic aromatic | |
| the membrane contains skeletal support | substitution reaction, atomic transfer | |
| the membrane contains at least two different | radical polymerization (ATRP), or cross | |
| membrane bound acidic ionomers | linker polymerization (XLP) | |
| | sidechain block polymers e.g. PSf-R | |
| | A/B alternating block polymers e.g. | |
| | PESf-b-(Ph₂SO₂)(PhO₆)(PhSA)₁₀ | |
| | comb multi-block copolymer e.g. | |
| | PSf-b-(PSf-co-STz) | |
| | alternating di-block copolymers, e.g. | |
| | (SPAESf)ₓ-b-(PAESf)_{y}, (SPAESf)ₓ-b-Pl_{y} | |
| | tri-block polymer e.g. P((S²⁻)(R-co- | |
| | R′))-b-((PhSO₃H)₆)₂ | |
| | quad-block copolymer, e.g. PSS-b-Et- | |
| | b-(Eth-ran-Prp)-b-PSS | |
| | penta-block copolymer, e.g. (t-BuS)- | |
| | b-(Eth-co-Prp)-b-(PSS-co-PS)-b-(Eth-co- | |
| | Prp)-(t-BuS) | |
| | mirrored quad-block copolymer, e.g. | |
| | SPh30-b-PAESf-b-PAESf-b-SPh30 | |
| | branched multi-block copolymer e.g. | |
| | PASf(CF₃)₂-b-(PESf-g-SPPhO), (PA(CF₃)₂ | |
| | (F₃Ph)₂-b-(PAE-g-SPS) | |
| | random multi-block copolymer e.g. | |
| | SPAESf-b-TFPh-b-PAESf-b-TFPh | |
| | the micropores are formed by sugar | |
| | the skeleton comprises a quasi-rigid | |
| | polymer coated with PVA | |
| | one of the membrane bound acids | |
| | comprises phosphonic or sulfonic acid | |
| | the IEM includes permanent fillers | |
| | the IEM includes ionic liquids | |
| | mobile IL cations are sequestered by | |
| | a nanocoating and endoskeleton | |

### Structural Membrane Innovations.

Another embodiment of this invention is the integration of skeletal support within an ion exchange membrane [FIG. 429D], where by a grid-like matrix of inert pillars divides the membrane into multiple discrete window-pane-like regions, each containing an electrically conductive ionomeric membrane. Through chemical bonding between the two, the skeletal matrix provides mechanical support for the conductive membrane thereby preventing tearing, cracking, or extreme deformation during manufacture and operation. The skeleton also provides protection against cycle life failures from humidity cycling, temperature cycling, and power cycling. Uniquely the skeleton limits swelling of the membrane under conditions of high hydration, e.g. during operation at high currents or in an ambient of high relative humidity, by preventing in-plane swelling laterally by the physical counterforce of the rigid pillars. The skeleton also reduces swelling vertically, i.e. perpendicular to the membrane, by constraining atomic displacement through chemical bonds to the pillar tops.

In one embodiment the inert pillar is hydrophobic and the active membrane panes are hydrophilic where an ampipathic linking molecule such as a solvent, cross-linker, or molecule glue containing both polar and non-polar bonding sites chemically binds the two dissimilar polymers into a unitary membrane having the benefit of both superior mechanical strength and good conductivity. This is in direct contradiction to a composite reinforce membranes (CRM) where increasing the mole fraction of the inert hydrophobic polymer improves film strength by sacrificing conductivity and vice versa.

In various embodiments, the skeletal pillars comprise hydrocarbon or fluorocarbon compounds such as polytetrafluoroethylene (PTFE), polyvinyl alcohol (PVA), polyimide (PI), or hexafluoropropylene oxide (HFPO), optionally fortified by rigid fillers of carbon fibers, pristine carbon nanotubes, electrospun polymer fibers, plastic shards, graphene, or other strengtheners. In related embodiments, conductive ionomeric membranes comprise any of the polymers or copolymers described in this application including PFSA homopolymer; PFSA-PTFE composite reinforced membranes (CRMs); polyphenylene; polysulfone; poly phosphazene; poly fluorocarbon glasses like PFMMD; polyimide; covalent triazine; heteropolymers of arylene, ketone, ether, sulfone and nitrile groups such a SPEEK or PAESf; anhydrous membranes such as phenylene bibenzimidazole (PBI); and biopolymers including polydopamine (PDA), chitosan, and cellulose acetate (CA).

Fabrication of skeletally supported IEMs include first polymerizing the skeletal pillar matrix in accordance with a pattern defined by a mold chaise inserted into a casting mold, then removing the mold insert and treating the skeleton to improve bonding such as chemically roughening its surface then applying a pillar link bonding agent or molecular glue. The empty spaces in the mold are then filled with the ionomeric monomer along with reagents and solvents for cross linking and polymerization. After curing, the skeletal membrane is removed from the mold.

In an alternative sequence the skeletal monomer is loaded into the mold along with the mold chase insert, then treated with a weak bonding agent or glue such as hexafluoropropylene oxide (HFPO) and baked to loosely bind the pillar monomers together into a unitary structure. The mold chaise insert is then removed and the empty spaces filled with ionomeric monomer along with reagents and solvents for cross linking and copolymerization. During copolymerization the pillar monomers are polymerized into he skeletal matrix, the ionomeric monomers are polymerized into the conductive ionomeric membrane, and if compatible the pillar monomers and the ionomer monomers bond to one another forming a seamless unitary ion exchange membrane with embedded skeletal support. After curing, the skeletal membrane is removed from the mold.

In one set of embodiments the skeletal matrix includes two different width pillars—narrow endoskeletal pillars crossing throughout the membrane and a wider exoskeleton circumscribing the membrane. In another embodiment, multiple IEMs are concurrent fabricated on a single sheet with exoskeletal pillars delineating one IEM from another. In yet another embodiment, the exoskeletal pillars are cut by lasers to singulate the IEMs from one another without disturbing the endoskeletal matrix internal to each IEM. In yet another embodiment, the entire sheet of multiple skeletal IEMs is attached to a thicker frame circumscribing the IEM sheet's periphery and used during by automated manufacturing or robotic handlers to grab ahold of the membrane.

### Gas Transport Innovations.

Gas delivery to the catalyst coated membrane occurs in the gas diffusion layer, a porous carbon material surrounding the CCM. In one embodiment sheets of comparably sized gas diffusion layers (GDLs) are attached to the both anode and cathode sides of IEM sheet prior to laser singulation [FIG. 47]. In another embodiment, the IEMs are singulated before being attached to the gas diffusion layers. In versions where the anode and cathode catalyst layers are dissimilar, in one embodiment an identifying mark is included on one side of the frame or exoskeleton [FIG. 50] to distinguish anode from cathode during manufacturing or assembly.

In yet another embodiment the endoskeleton is combined with a membrane nanocoating to prevent leakage of permanent fillers or ionic liquids present in the molecular matrix of the polymeric membrane. The combination of endoskeletal support and ionic liquid uniquely solves the major issue plaguing ionic liquids—that overtime the IL fluid leaks out of the membrane. With the inclusion of inventive endoskeletal and exoskeletal pillars through the membrane and circumscribing its perimeter, the IL cannot leak lateral out of the polymer. In another embodiment [FIG. 478], a nanocoating on the face of the membrane prevents IL leakage into the gas diffusion layer. The coating may be interfacial or embedded within the catalyst layer (CL).

The invention further comprises an heterogenous catalyst layer (CL) deposited or laminated onto the improved IEM forming an improved catalyst coated membrane (CCM) also known as a three-layer membrane electrode assembly (MEA3). The heterogenous catalyst layer may include additives comprising various blends of carbon, transition metal catalysts; metal oxides and nanoclusters; and CL fillers of bismuth, polyhedral silsesquioxanes (POSS, DDSQ), metal-organic frameworks (MOFs), graphene oxide (GO), functionalized carbon nanotubes (CNTs), boron nitride (BN), PTFE nanospheres, and dopamine (DPA). These additives may be blended into the catalyst layer, or can be deposited as a nanocoating onto the IEM prior to catalyst layer formation creating an interstitial layer between the membrane and the CL. Alternatively the additives may be coated onto the catalyst layer forming an interstitial layer between the gas diffusion layer and the catalyst layer.

Functions of the additives include sequestering and/or degrading atmospheric toxins such as carbon monoxide (CO) or other harmful compounds such as H₂O₂ preventing them from reaching and damaging the catalyst coated membrane (CCM) or ionomers within the IEM. Other benefits include improving electrical conductivity within the catalyst layer; reducing interfacial resistance and contact potentials lowering activation losses; and enhancing catalysis to increase the efficiency of hydrogen oxidation reactions (HOR) or oxygen evolution reactions (OER) in the MEA anode or to increase the turnover rates for oxygen reduction reactions (ORR) or hydrogen evolution reactions (HER) in the MEA cathode.

The invention further includes the device and processing of a inventive heterogeneous gas diffusion layer (hGDL) in one embodiment comprising a dense microporous film coated with a stepped or graded carbon ‘diffusion layer of decreasing density and increasing porosity with the top of the GDL having the greatest porosity. Compared to existing uniform density films, the graded carbon GDL improves gas diffusivity and reduces the average electrical resistance of the GDL.

In one embodiment the gradation in density is achieved by increasing the length of carbon fibers to decrease density. In one embodiment the GDL graded carbon is printed using three print heads each applying carbon ink of different carbon fiber lengths. In an alternative embodiment a single print head dispenses ink of varying composition to create the graded density.

In other embodiments the hGDL may include boron nitride or MOFs within the carbon layer to suppress NO and environmental toxins. Alternatively, the bottom of the GDL may be coated with a nanocoating comprising a blend of carbon and catalyst to minimize interfacial resistance.

In another embodiment the top of the GDL can be coated with a nanocoating of non-catalytic metal to reduce interfacial resistance between the GDL and the bipolar plate. In yet another embodiment the bottom of the bipolar plate is coated with the same metal as deposited on the top of the GDL. During assembly the contact of two identical materials does not cause any differential contact potential, which is beneficially manifested as a reduced voltage drop and a lower effective resistance for the membrane.

The combination of the inventive hGDL with various innovative elements of the aforementioned MEA3 results in an improved five-layer membrane electrode assembly (MEA5) referred to herein as a PEM+ (pronounced PEM plus) or AEM+ membrane. Measurement data of fabricated MEA5 fuel cells confirm the PEM+ embodiment of this invention achieves 40% higher conversion efficiencies than existing Nafion® membranes, and doubles the delivered power output of the fuel cell for the same amount of waste heat generation.

BPP & μstack FC Innovations.

Attaching a high-conductivity bipolar plate (BPP) or tripolar plate (TPP) to the aforementioned improved MEA5 assembly results in a seven-layer membrane electrode assembly (MEA7) with improved performance. As an embodiment of this invention, the bipolar plate typically 2 mm thick in conventional fuel cells, is to a thickness of under 0.5 mm, e.g. to 0.45 mm, reducing the BPP electrical resistance by between 50% and 75%.

Aside from lowering its electrical resistance, thinning the carbon or composite bipolar plate significantly reduces its thermal resistance of heat conduction. In one embodiment, assembling a twelve layer μstack fuel cell results in a substantial reduction in thermal resistance. In operation heat flow conducted from the topmost membrane through the entire μstack and into a temperature controlled baseplate exhibits an order-of-magnitude lower thermal resistance than possible using forced air convection, thereby eliminating the need for expensive liquid cooling of the fuel cell stack. By eliminating the need for liquid cooling, the tripolar plate and its cooling channel can be replaced by a thinner lower resistance bipolar plate, thereby further reducing internal heating within the cell.

The improved ion exchange membrane made in accordance with this invention has many applications including μstack fuel cells, intelligent buffered fuel cells (iBFC), electrolytic water-to-hydrogen conversion (WHC), and well as deionization, water filtration, and dialysis. In a intelligent buffered fuel cell [FIG. 431A] an array of μstack fuel cells generates electricity from a fuel source such as gaseous hydrogen, storing the charge coulombically in an electrochemical energy storage buffer comprising an array of batteries such as lithium ion cells or other chemistries. Current flow between the fuel cell array and the buffer is controlled by an charge transfer regulator (QXR), and inventive power electronic component able to optimally charge an array of electrochemical cells from a current-dependent power source such as fuel cell. Unlike a normal battery charger, the QXR does not rely on a stiff voltage source as its input, but instead limits input current to prevent or minimize of fuel cell voltage sag. The QXR also prevents overcharging of the buffer limiting both the charge current and the maximum buffer voltage on the μstack and the voltage on each individual cell, i.e. balancing the voltage evenly among the buffer cells [FIG. 441]. It also protects the fuel cell from excessive temperatures [FIG. 455].

In another embodiment of the invention, the number of μstacks in the fuel cell array is dynamically varied to maintain the closest match between the fuel cell output voltage and the minimum buffer input voltage needed to reliably charge the string of buffer cells to full charge. The number of fuel cells is adjusted by a power multiplexer switch array. Examples including switching between two-or-three 21-layer μstacks [FIG. 441], or in with finer voltage granularity, selecting between three-or-four 12-layer μstacks in a four μstack fuel cell array, or among three, four, or five 12-layer μstacks in a five μstack fuel cell array [FIG. 452]. The net benefit of a dynamic fuel cell stack is to ensure a minimum fuel cell stack voltage despite changes in voltage sag with current, temperature, and humidity while also limiting the maximum output voltage of the fuel cell stack to avoid the need for more costly high voltage components.

Exemplary intelligent buffered fuel cell (iBFC) designs with 24V minimum output voltage includes a dynamic fuel cell design comprising three-to-five μstacks with approximately 60 total layer maintaining a voltage range of 24V to 40V able to function down to a 0.4V per layer FC voltage corresponding to 27% relative humidity [FIG. 443, FIG. 453]. Alternative designs limit the maximum fuel cell stack voltage to 32V including a two-state multiplexer circuit that works down to a 0.5V per layer fuel cell voltage for a minimum relative humidity of 34% [FIG. 450] and a three-state multiplexer able to function to 0.4V per layer at 27% humidity [FIG. 454].

### Power Circuit & System Innovations.

Various circuit topologies [FIG. 456, FIG. 457] include QXR operation where the output current of the fuel cell during buffer recharging is maintained at precisely the sum of the load current and the buffer charging current so long that the fuel cell and buffer maximum currents are not exceeded. During iBFC discharging the maximum output current comprises the peak fuel cell current plus the peak discharge current of the buffer, generally at 1 C discharge rate, i.e. delivering full current for one hour.

In one embodiment, the iBFC delivers power to an electrical load in one of three conditions [FIG. 471]. In continuous current mode also known as steady state operation the fuel cell stack provides the full load current and the buffer array remains charged. Unlike a battery that cannot generate electricity itself, the buffered fuel cell can deliver power indefinitely so long that hydrogen fuel is regularly replenished.

In a second higher current mode referred to as “power-on-demand”, the iBFC delivers power to the electrical load from both its fuel cell and simultaneously from charge stored in its buffer but only as long as the buffer retains stored charge. Depending on its design, the iBFC output power can range 2× to 5× its steady state continuous current mode. After discharging for one hour at a 1 C rate, the iBFC is still able to maintain its continuous output current while a battery is completely dead. As such, a battery has only a power-on-demand operating mode where the iBFC supplies both power-on-demand and continuous current. Moreover in the steady state mode, whenever the load demand drops below the peak power output limit of the fuel cell stack, the excess available power is diverted to recharge the buffer array of its spent charge. In this manner the iBFC functions as self recharging battery appearing to a user as a perpetually charged power source.

In a third state, a 10-second current transient both the iBFC and a conventional battery pack behave similarly, delivering up to 10× its power-on-demand current rating. The ability to deliver high transient current necessary for supplying capacitive inrush current spikes and motor startup, means the effective output impedance of the iBFC is comparable to lithium ion batteries and an order of magnitude less resistive than conventional fuel cells.

In claim language the iBFC comprises “a fuel cell based power generator with integrated charge storage cable of delivering high power-on-demand currents to an electrical load for a limited interval and continuous power perpetually from a fuel source, whereby excess generated power not consumed by the electrical load replenishes charge lost by the energy buffer during higher power demand periods.” Such beneficial electrical performance cannot matched by any power source available today, either a battery or fuel cell.

In another embodiment the iBFC includes protective disconnect circuitry [FIG. 438] to prevent damage from its output connection including the prevention of (i) excessive current conduction in an electrical load or short, (ii) over-discharging the buffer below its over-discharge voltage, (iii) overheating, (iv) reverse current flow whereby any current flowing from ‘into’ the output of the iBFC is interrupted. In another embodiment, the output terminals of the iBFC include a bypass function so a disabled iBFC appears as a low resistance electrical circuit bypass. In another embodiment the iBFC has a separate electrical input [FIG. 434C, FIG. 435, FIG. 438] to directly charge the electrochemical buffer array from an electrical power source rather than drawing power from the fuel cell and expending fuel. Electrical power input may include grid power, backup generator power, or renewable energy from wind generators or solar PV panels.

In another set of embodiments, the iBFC is configured as a 5 kW power-on-demand ‘iBFC power blade” an inventive temperature regulated printed circuit board inserted into a rack mounted system called an energy bank capable of connecting up to 100 kW of iBFC generated power to a power microgrid [FIG. 463]. In this modular design, the energy bank chassis provides fuel and cooling to operating power blades.

In another embodiment, a fuel cell μstack includes gas ports and electrical connections on its underside [FIG. 465] which when mounted flush onto the power blade forms a ingress and egress gas connections between the backplate and the μstack module without the need for flexible tubing. In another embodiment, the backplate is cooled thereby able to conduct heat out of the μstack an into the temperature regulated backplate [FIG. 470] to prevent overheating of the fuel cell. In another embodiment, the process used to fabricate the power blade backplate is described [FIG. 466A to FIG. 466E].

In exemplary power blade designs multiple fuel cells are mounted flat on the power blade backplate while lithium ion battery cells such as 18650 cylindrical type cells are mounted perpendicular to the PCB [FIG. 463] and where the μstack FCs and the battery buffers are approximately the same height. One exemplary power blade includes twelve fuel cell μstacks with 96 buffer cells [FIG. 472A], Conversely in another design [FIG. 472H] the power blade contains only three μstack fuel cells but 480 buffer cells.

In general, the greater the fractional area of the power blade dedicated to buffer cells the greater the transient current and higher the power-on-demand ratings are, but at the expense of a lower continuous power output capability [FIG. 473A]. Examples range from 1 kW continuous power with 7 kW power-on-demand to 4 kW of continuous power but only 5.2 kW power-on-demand.

### Glossary

Acid-base polymers—Acid-base polymers, also known as polyelectrolytes, are polymers that contain acidic or basic functional groups which can dissociate in water to form charged species, enabling ion exchange. Example include poly(acrylic acid) (PAA), poly(methacrylic acid) (PMAA), sulfonated polystyrene (SPS), poly(ethyleneimine) (PEI), poly(vinyl alcohol) (PVA borate or PVA phosphate), poly(4-vinylpyridine) (P4VP), poly(2-vinylpyridine) (P2VP), poly(styrene sulfonic acid) (PSSA), poly(vinylpyrrolidone) (PVP), and poly(allylamine) (PAAm). Acid-base copolymers—The use of blended copolymers having different material, chemical, and electrical properties where at least one of the copolymers comprises an acid-base polymers.

Examples include SPEEK-PVA-PBI, SPEEK-PEI, SPSU-PBI, PA-PBI, PANI-PBI, PBI-ZIF, PBI-PVBC, PAEBI, PSU-P4VP, OPBI-OPBI-TG, SPA-PVA, CMC-PVA-AA, PTPU-PSS-DVB, PFA-PSSA, PS-co-sPSS, sPh-CₙH₂ₙ₊₂, and sPTFS-X. Made in accordance with this invention, further improvements to acid-base copolymers include a reenforced endoskeletal support matrix, sacrificial and permanent fillers to control film porosity, and scavenger MOFs to protect against CO poisoning.

Anion—An anion is any negatively charged ion attracted to a positively charged electrode, i.e. anode, of a electrochemical cell. Anions comprise atoms or molecules formed by the addition of extra electrons through the process of reduction. Examples include the hydroxyl radical —OH; ions of halogens such as chlorine Cl⁻, bromine Br⁻, and iodine I⁻; dichromate anion (Cr₂O₇)²⁻; and sulfate anion (SO4)²⁻. An anion may comprise a mobile negatively charged molecule such as OH- or a negative radical of an ionic liquid used to conduct current in an anion exchange membrane. Alternatively, an immobile anion is a membrane-bound ionized acid in a proton exchange membrane after losing a H⁺ to solution.

Anion exchange membrane—A anion exchange membrane or AEM, also referred to as an alkaline or hydroxide membrane is a type of membrane used in anion fuel cells which conducts negatively charged alkaline ions, usually —OH hydroxide ions through an IEM exclusively containing positively-charged immobile ionomers. In operation oxygen and water combine in the cathode to form —OH transiting the membrane to the anode where the hydroxide reacts with the fuel, typically hydrogen to form H₂O waste water, or methanol (CH₃OH) to form waste water and CO₂.

Anode—In the context of fuel cells, the electrode of an electrochemical cell where oxidation occurs. In a PEM, the anode supplies cations transported across the membrane and supplies free electrons via its terminal to an external circuit as electricity. In the context of IEM water hydrolysis the anode is the electrode where an oxygen evolution reaction (OER) occurs. In acronym such as ACL for anode catalyst layer, the term cathode is generally abbreviated by the uppercase letter ‘A’.

Bipolar plate—A bipolar plate or BPP is an electrically conductive plate used to carry gas to the MEA5 fuel cell assembly transporting fuel to the anode, and oxygen or air to the cathode. The BPP also carried electric current between stacked fuel cells from the anode of one fuel cell to the cathode of the next.

Catalyst layer—A thin interfacial layer located between an ion exchange membrane and its gas diffusion layer comprising a combination of carbon, transition metals such as platinum acting as catalysts and optionally metal-oxides such as TiO₂, various additives such as MOFs and POSS, and boron nitride to inhibit NO diffusion. The catalyst layer on the cathode side of a membrane called the CCL may differ chemically and stoichiometrically from the anode catalyst layer, the ACL.

Cathode—In the context of fuel cells and batteries, a cathode is the electrode of an electrochemical cell where reduction occurs. In a PEM, the cathode receives protons transiting the membrane, then combines them with oxygen to form water as a byproduct. Hydrogen PEM fuel cells therefore do not produce CO₂ or other greenhouse gasses. In the context of IEM water hydrolysis the cathode is the electrode where a hydrogen evolution reaction (HER) occurs. In acronyms, the term cathode may be abbreviated by the uppercase letter ‘C’ or by the letter ‘K’, nomenclature evolved from power semiconductors used to eliminate ambiguity caused by the widespread use of capital C to symbolize catalyst, collector, carbon, charge, coulombs, capacitance, charge-rate, or degrees centigrade.

Cation—A cation is any positively charged ion attracted to negative charged electrode, i.e. cathode, of a electrochemical cell. Cations comprise atoms or molecules formed by removal of electrons through the process of oxidation. Examples of cations include ionized hydrogen H⁺, hydronium ions H₃O, ammonium ions NH₄₊, calcium ions Ca₂⁺, and ions of various transition metals such as silver ions Ag⁺, ionized aluminum Al₃⁺, mercurous ions (Hg₂)₂⁺, ferrous ions Fe²⁺, and ferric ions Fe₃⁺. In a proton exchange membrane, a mobile cation may comprise a unbound proton, i.e. a hydrogen ion H⁺; a mobile positively charged molecule such as the hydronium ion H₃O⁺; or the positive radical of an ionic liquid. Alternatively, an immobile cation is a membrane-bound ionized functional group in a anion exchange membrane after losing OH⁻ or gaining H⁺ from solution.

Cation exchange membrane—A cation ion exchange membrane is an alternative name for a proton exchange membrane or PEM.

CCM—The term CCM is an acronym for a catalyst coated membrane comprising a sandwich of a central ion exchange membrane covered on both sides by a coating comprising a catalyst such as Pt and other materials such as carbon or nanoparticles. The term CCM is synonymous with a three layer membrane electrode assembly MEA3.

Closed cathode fuel cell—A closed cathode fuel cell is a fuel cell where the gas channels for hydrogen supply to the anode, oxygen or air supply to the cathode, and coolant air or fluid are separated offering superior control of fuel cell hydration and maintaining performance in harsh environments. Using a dedicated oxygen supply, a closed cathode fuel cell can operate in a vacuum such as in space applications.

Direct methanol fuel cells—A direct methanol fuel cell (DMFC) is proton exchange membrane (PEM) based fuel cell where methanol fuel is consumed to produce electricity. In operation the methanol is first converted to hydrogen which is transported across the PEM membrane. As the byproduct of a hydrogen fuel cell is water and CO₂, DMFC is not considered a green energy source. DMFC emits 35% less greenhouse gasses than gasoline internal combustion engines.

Electron—An electron (e⁻) is a stable subatomic particle having a negative electric charge present in atoms and ions. Electrons electrostatically facilitate chemical bonding between atoms. They are also the dominant charge carrier of electrical conduction in metals and in many solids, but not exclusively in ionic liquids or semiconductors where anions or holes may be significant. Ionized free electrons are not considered anions. Electrons are not conducted by proton exchange membranes.

Endoskeleton—Pillars of inert polymer transecting an ionomeric membrane into panes and providing mechanical support to conductive polymer. The endoskeletal matrix merges with the wider exoskeleton circumscribing the periphery of each IEM.

Exoskeleton—Pillars of inert polymers and strengthening pillars circumscribing the inventive skeletal IEM. The exoskeleton forms a continuous grid-like pattern with the endoskeletal pillars it contains and connects by tie bars to a frame supporting multiple IEMs in a singular sheet. The exoskeleton is cut by laser to separate individual membranes from one another and from the membrane frame, a process referred to as singulation.

Functionalization—The process of functionalization involves the conversion of an insulating non-conductive polymer into a conductive ionomeric polymer by the introduction of ionomer molecular groups or other charge conducting materials into the polymeric matrix. Modifications to the matrix may include sulfurization, copolymerization, grafting, or inducing radiation damage onto the polymeric chain. Another method to functionalize a polymer is through doping, the introduction of conductive or ionomeric fillers into the matrix. Dopants including metal oxides, metal oxide frameworks (MOFs), polyhedral oligomeric silsesquioxanes (POSS), nanoparticles and nanocomposites, electrospun nanofibers, carbon nanotubes, and proton ionic liquids (PIL). Made in accordance with this invention MOFs may contain a mix of ionomers and protective scavenger metals.

Gas diffusion layer—A gas diffusion layer or GDL is a porous materials comprising carbon fiber or carbon compounds used in fuel cells and electrolyzers to transport gasses between a bipolar plate and a catalyst layer of a CCM and to carry electric currents through its fibrous matrix. The GDL may comprise a uniform homogenous material, a two-step construction with a smaller pore MPL microporous layer and less dense carbon coating; or as disclosed herein comprise a heterogenous gas diffusion layer (hGDL) comprising a MPL coated multiple layers or a continuous gradation of carbon of varying density to enhance conductivity and improve gas diffusion. In membrane based fuel cells, electrolyzers, and electrodialysis systems, an important role of the GDL is to spread gasses emerging from narrow channels of a bipolar plate uniformly across a membrane's surface through lateral diffusion.

Glassy amorphous polymers—Perfluorinated polymers containing large subgroups along the polymer's backbone such as perfluoro-methylene-methyl-dioxolane sulfonic acid (PFMMD-SD), and perfluorodimethyldioxole (PDD) are categorized as glassy amorphous polymers. By impeding the periodicity of the polymer, crystallinity of the matrix is randomly disrupted resulting in amorphous regions comingled with semi-crystalline regions. Sulfonic acid or grafts of PFSA are included within the matrix to control film conductivity. Made in accordance with this invention, further improvements to—partially perfluorinated polymers include a reenforced endoskeletal support matrix, sacrificial and permanent fillers to control film porosity, and scavenger MOFs to protect against CO poisoning.

Heterogenous gas diffusion layer—A heterogenous gas diffusion layer or hGDL a described herein is a gas diffusion layer used in membrane devices comprising a non-unform carbon density in the carbon coated layer positioned atop a denser microporous layer. The hGDL may be formed using multizone printing from a multi-head printer or by blending multiple solutes in single head printing.

Hopping conduction—In an ion exchange membrane, hopping conduction aka Grotthuss transport involves an anion or cation hopping from one ionomer to another in succession. The ionomers may comprise sulfonic acid in PEMs and quaternary ammonium or N-containing cations, for example based on pyrrolidinium (PY), piperidinium (PRD), and imidazolium (IM) moieties in AEMs.

Hydrogen fuel cell—A proton exchange membrane (PEM) based fuel cell where hydrogen is the fuel consumed to produce electricity. The byproduct of a hydrogen fuel cell is water. With no CO₂ effluent hydrogen fuel cell based electricity is considered as a green energy source.

Hydrogen ions—Hydrogen ions comprise any cation comprising ionized hydrogen charges including ionized elemental hydrogen or molecules containing ionized hydrogen such as hydronium ions.

Hydronium ions—A hydronium ion is a molecule combining water (H₂O) and a proton (H⁺) resulting in the hydrophilic cation H₃O⁺ capable of vehicular charge transport.

Ion—An ion is any elemental atom or molecule that has lost an electron through the process of oxidation resulting in net positive charge or gained an electron through the process of reduction resulting in a net negative charge.

Ion exchange membrane—An ion exchange membrane in a semi permeable membrane able to selectively control the conduction of ions by their charge state. Proton exchange membranes (PEM) conduct positively charged cations and inhibit transport of negatively charged anions. Conversely, anion exchange membranes (AEMs) conduct negatively charged cations but suppress transport of positively charged cations. All IEMs suppress electron conduction through the membrane.

MEA3—The three layer catalyst coated membrane (CCM(comprising a sandwich of a central ion exchange membrane covered on both sides by a coating comprising a catalyst such as Pt and other materials such as carbon or nanoparticles.

MEA5—The five-layer membrane assembly comprising a MEA3 sandwiched between two gas diffusion layers (GDLs).

MEA7—The seven-layer membrane assembly comprising a MEA6 sandwiched between two bipolar or tripolar plates.

Membrane electrode assembly—The term membrane electrode assembly (MEA) describes the layers of material constructing a fuel cell comprising the catalyst coated membrane or three layer MEA3, which sandwiched by two gas diffusion layers (GDLs) define a five layer MEA5. The addition of two bipolar or tripolar plates surrounding the MEA5 forms a seven-layer assembly referred to as MEA7.

Membrane frame—The outer edge of a sheet of IEMs used for automated or robotic handling on the matrix prior to singulation. The membrane frame connects to the exoskeleton of the individual IEMs through narrow tie bars which are removed during singulation of the sheet into individual IEMs.

Micro-stack Fuel Cell—The innovative micro-stack (μstack) fuel cell as disclosed herein comprises the series connection of between 10-to-24 individual MEA7 fuel cell layers housed in a single fuel cell assembly and capped between two opposing endplates. Compared to high power fuel cell stacks, the voltage, power and heat generated from a μstack is substantially less, e.g. under 40V and less the 1 kW. Advantages of the μstack is its low profile for improved industrial design, significantly reduced thermal resistance, better conductive cooling, and the ability to function in multiplexed dynamic fuel cell arrays.

Modified perfluorinated polymers—Modifications of perfluorosulfonic acid (PFSA) to enhance a polymer's material and electrical performance comprise dopants and fillers including PTFE; silica and silicates; titanium oxides; zirconium; imidazole; triazine; zeolite nanoparticles; platinum-titanium nanoparticles; functionalized carbon nanotubes (CNTs); metal oxide frameworks (MOFs); poly(methyl methacrylate) (PMMA) nanoclusters; polyhedral oligomeric silsesquioxanes (POSS); double decker silsesquioxane (DDSQ); ferrous, zinc, and chromium nanoclusters; tungsten nanoparticles; nanofibers; graphene oxide; and proton ionic liquids. Made in accordance with this invention, further improvements to modified perfluorinated polymers include a reenforced endoskeletal support matrix, sacrificial and permanent fillers to control film porosity, and scavenger MOFs to protect against CO poisoning.

Non-fluorinated polymers—Comprising aliphatic or aromatic polymers with benzene ring structures in the backbone or in the pendant groups, hydrocarbon based polymers lacking fluorine are cheaper, exhibit reduced oxygen leakage and fuel crossover, and suffer less temperature degradation to PFSA films. Examples include sulfonated polyarylene ether sulphone (SPAES), sulfonated poly ether-ether ketone (SPEEK), sulfonated poly ether-ether sulfone (SPEES), polysulfone (PSf, PSU), chitosan (CS), sulfonimide branched poly(phenylenebenzophenone)s (SI-PPBP), and anhydrous poly(phenylene-bibenzimidazole) (PBI). Unlike perfluorinated polymers containing environmentally persistent and toxic pollutants known as forever chemicals, hydrocarbon based membranes are chemically inert. As a disadvantage, non-fluorinated polymers exhibit lower conductance than PFSA. Made in accordance with this invention, further improvements to modified perfluorinated polymers include a reenforced endoskeletal support matrix, sacrificial and permanent fillers to control film porosity, and scavenger MOFs to protect against CO poisoning.

Open cathode fuel cell—In a hydrogen PEM fuel cell, open cathode fuel cell comprises a fuel cell membrane electrode assembly where the cathode is open to an ambient air supply an does not require a dedicated oxygen supply. In an open cathode fuel cell the air supply also provides cooling of the assembly.

PAE—Polyarylene ether (PAE) polymers comprise thermoplastics featuring a mainchain of alternating rigid aromatic rings and flexible ether bonds, conferring numerous beneficial material properties including high-temperature resilience; oxidative stability; and resistance to solvents, alkali, and acids. Variations of polyarylene ethers depend on which functional groups are attached to the polymer's backbone. Specifically, polyarylene ethers having ketone segments on the mainchain are referred to as poly(arylene ether ketone) (PAEK), while those with sulfone segments on the mainchain are referred to as poly(arylene ether sulfone) (PAES). Polyarylene ethers with cyano (C≡N) functional groups on sidechains are referred to as poly(arylene ether nitrile) (PAEN). PAE can also form sulfonated copolymers P(SPAES)-co-TBPh.

PAm—Polyamide (PAm, PA) is a thermoplastic polymer of repeating units linked by amide bonds formed by step-growth polymerization or solid-phase synthesis. Monomers may comprise amides themselves resulting in a homopolymer but polyamides may also easily be copolymerized. Functionalization of polyamide can be involve sulfonization by fuming sulfuric acid or by aqueous treatment in solutions of SO₃ of CCl₄ or by forming copolymers such as sSPA-co-Sim.

PBI—Phenylene-bibenzimidazole (PBI) and its variant pyridine polybenzimidazole (PyPBI) comprise an acid-base hydrocarbon polymer offering exceptional thermal and chemical stability. Preparation of PBI can be achieved by condensation reaction of diphenyl isophthalate with tetraaminodiphenyl. PBI membranes are dense and rigid with strong hydrogen bonding and low gas permeability. Because of its basic structure, Polybenzimidazole can be functionalized by strong acids to form ionomers for proton conduction. PBI doped with phosphoric acid can be used as high temperature electrolyte in direct methanol fuel cells. The also can be functionalized with sulfonic acid in a variety of configurations and cross linked with other functionalized PBI chains, with poly(vinylbenzyl chloride) (PVBC), polyaniline (PANI), or zeolitic imidazolate framework (ZIF).

Partially perfluorinated polymers—Partially perfluorinated polymers such as grafted PFSA and PFSA copolymers including perfluoro-hydro-dimethyl-dioxolane-co-perfluorosulfonic acid (PFMMD-co-PFSA), fluorinated ethylene propylene (FEP), polyvinylidene fluoride (PVDF), and sulfonated fluorinated polyethersulfone (sFPESf) contain reduced levels of fluorine on the polymer's mainchain, generally substituted by hydrocarbon groups providing an added degree of control over crystallinity, fuel crossover, conductivity, permeability, and temperature dependence. Made in accordance with this invention, further improvements to partially perfluorinated polymers include a reenforced endoskeletal support matrix, sacrificial and permanent fillers to control film porosity, and scavenger MOFs to protect against CO poisoning.

PDD—Perfluorodimethyldioxole (PDD) comprises a perfluorinated glassy amorphous polymer functionalized by sulfone ionomers to modulate film conductance. PE—Polyethylene (PE) is polyolefin thermoplastic offering good mechanical strength. Polyethylene can be converted into an ionomer by introducing sulfonic acid (sPE) or bromine (BrPE) to modulate film conductivity.

PEK/PEEK—Poly ether ketone (PEK) and polyether ether ketone (PEEK) are semicrystalline thermoplastic polymers in the polyaryletherketone (PAEK) family formed by step-growth polymerization via the dialkylation of bisphenolate salts. PEEK is highly resistant to thermal degradation and to attack in both organic and aqueous environments. The polymers can be functionalized into ionomers using sulfuric acid to produce a wide range of options by varying the number of ether and ketone groups on the chains, including sPEK, sPEEK, sPEKK, sPEEEK, sPEEKK, sPEKKK, sPEKEKK, and copolymers sPEK-co-PEK (2PEK).

Permanent filler—An permanent filler (PF) is an additive mixed with IEM monomers and molded permanently into polymeric matrix, affecting conductivity, crystallinity, atomic density, hydrophilicity, catalytic turnover, hydration, swelling, durability, strength, and reliability. Examples include pristine and functionalized bismuth compounds, graphene oxides, carbon nanotubes, silicates, zirconia, tungsten, metal organs frameworks, zeolite, nanostructures, and polyhedral silsesquioxanes. While permanent fillers are normally additives included in the ionomeric membrane, they may also be integrated into nanocoating, catalyst layers, or within a gas diffusion layer. In contrast to sacrificial fillers which are dissolved and removed subsequent to molding, permanent fillers remain within the polymer matrix indefinitely. Added to the mold compound before polymerization, permanent fillers are distinct from ionic liquids that are soaked into the membrane after polymerization and prior to attachment of gas diffusion layers.

PFEKN—Poly(fluorenyl ether ketone nitrile) (PFEKN) is a perfluorinated polymer containing nitrile groups synthesized by nucleophilic substitution polycondensation of dihydroxy-naphthalene-disulfonic acid disodium salt resulting in a sulfonated polymer sPFEKN, the degree of sulfonation and conductivity of which depends on the molar fraction of its reactants.

PFMMDD—Perfluoro-methylene-methyl-dioxolane sulfonic-acid (PFMMD-SA) comprises a perfluorinated glassy amorphous polymer functionalized by sulfone ionomers to modulate film conductance.

PFSA—Perfluorosulfonic acid, a perfluorinated ionomeric polymer used is a wide range of applications including ion exchange membranes for fuel cells, filters, electrolysis, electrodialysis and more. PFSA contains three components (a) polytetrafluoroethylene (PTFE) backbone; (b) a pendant comprising a sidechain of vinyl ethers such as (for example —O—CF₂—CF—O—CF₂—CF₂—), and (c) an electrically conductive ionomer comprising sulfonic acid (SO₃H). The length of the sidechain controls, crystallinity, conductivity, durability, fuel crossover, permeability, and the film's temperature operating range. Commercial trade names for PFSA ionomers include long-sidechain Nafion® and short-sidechain Aquivion®. Made in accordance with this invention, further improvements to modified perfluorosulfonic acid polymers include a reenforced endoskeletal support matrix, sacrificial and permanent fillers to control film porosity, and scavenger MOFs to protect against CO poisoning.

PI—Polyimide (PI) is a thermoplastic characterized by its thermal stability, good chemical resistance, and excellent mechanical properties. The general structure of polyimide is (—R—O—NR₂—O—) which should not be confused with polyamide characterized by amino acid groups (NH₂). Like other polymers nascent PI is a poor conductor. Functionalization of polyimide into an ionomer is accomplished through sulfonization via aromatic sulfonamides such as pBABTS resulting in the conductive ionomer sulfonated polyimide (sPI). The ionomer can also be copolymerized with PVDF for potential use in direct methanol fuel cells (DMFC).

PMMA—Polymethyl methacrylate (PMMA or acrylic glass), a thermoplastic polymer produced from the polymerization of methyl methacrylate (MMA), generally through PMMA is routinely produced by emulsion polymerization, solution polymerization, or bulk polymerization. Functionalization of PMMA may involve attaching a sulfonated phenol group to PMMA through a silicon intermediary or forming a copolymer or graft. Copolymers of PMMA-co-MAH, PMMA-g-PVDC, P(MMA-co-MAH-co-Mi), PE-g-PMMA, sBVlm-TfO-co-MMA.

Polyolefin—A class of thermoplastics, polyolefins use repeated monomeric units called olefins (alkenes) to form the polymeric mainchain. Ionomers such as sulfonic acid may be introduced within the polymer backbone, as side groups, or as the terminus of pendants grafted onto to the mainchain. Polyolefins have the general form (CH₂CHR)n where R is an alkyl group. Commercial examples pf polyolefin plastics include polyethylene (PE), polypropylene (PP), polyisobutylene, and polymethylpentene (PMP).

PP—Polypropylene (PP) is a low-density partially crystalline polyolefin thermoplastic derived from chain growth polymerization of its monomer propylene. Once polymerized, PP is resistant to most organic solvents. Although pristine polypropylene is non-conductive, its can be grafted or copolymerized with ionomeric polymers such as PFSA or PFSA-PTFE for use in ion exchange membranes.

PPh—Polyphenylene (PPh or PP) and para-phenylene (PPPh, PPP) are semicrystalline thermoplastic polymers comprising a linear polymer of the phenylene. Phenylene, a divalent radical C₆H₄ derived from benzene by displacement of two hydrogen atoms, is characterized by mechanical strength, stiffness, toughness, and chemical inertness. Sulfonated polyphenylenes include poly(benzoyl-phenylene) (sPPh), sulfonated polyphenylene quaterphenol (sPPh-QP), branched, sulfo-phenylated polyphenylene (sPPhB-H⁺), sulfonated Diels-Alder polyphenylene (sDAPPh), sulfonated hydrated phenylated polyphenylene (sPPPh-H⁺), hydroxylated sulfonated phenylated polyphenylene (sPPPh-OH), diiodo-biphenyldisulfonic acid (DilPhS). Bromated polyphenylene includes dibromo-biphenyldisulfonic acid (DiBrBPhS).

PSU—Polysulfone (PSU, PSf) is a thermoplastic polymer composed of aromatic groups, ether groups and sulfonyl groups characterized high strength, stiffness, with an extremely high melting temperature. To enhance conduction for fuel cell applications, polysulfone is functionalized through sulfonization of the benzene rings to produce sulfonated polysulfone (sPSf, sPSU)

Proton—The positive nuclei of ionized elemental hydrogen and a stable subatomic particle present in the nucleus of all atoms. Ionized hydrogen H⁺ is a cation electrostatically attracted to negatively biased electrodes.

Proton exchange membrane—A proton exchange membrane or PEM is a type of membrane used in cation fuel cells where positively-charged protons or cations transit an IEM exclusively containing negative charged immobile ionomers. The most common use of PEM membranes is in hydrogen fuel cells, where hydrogen fuel is ionized to form protons which subsequently transit the polymer membrane as H⁺ or H₃O ions.

PS—Polystyrene (PS) is a solid thermoplastic polymer made from monomers of the aromatic hydrocarbon styrene. Often used in protective packaging, polystyrene has good thermal stability. With ionomeric applications in fuel cells, polystyrene can be functionalized by sulfonating a block copolymer of polystyrene and poly(ethyl-ran-propylene) (sPSEP-PS). Another method is a block copolymer combining sulfonated polystyrene with polyisobutylene and with un-sulfonated polystyrene P(SSIBS). Alternatively, the monomer precursor to polystyrene can first be sulfonated to produce styrenesulfonate sSA. Thereafter the sulfonated monomer is then cross-linked to produce sulfonated polystyrene sPS. Because however polystyrene is not biodegradable, its use is restricted and its future uncertain.

PTFE—Polytetrafluoroethylene, a chemically-inert non-conductive fluoropolymer commonly known as Teflon® with beneficial material properties of nonreactivity, hydrophobicity, a low coefficient of friction, and good insulating properties. PTFE forms a portion of the polymeric backbone of perfluorosulfonic acid (PFSA).

PVA—Poly vinyl alcohol (PVA), a water soluble polymer with glue like cross-linking capabilities. Unlike vinyl polymers, PVA is not prepared by polymerization of the corresponding monomer, since the monomer, vinyl alcohol, is thermodynamically unstable. Instead it is prepared by hydrolysis of polyvinyl acetate. PVA can be made conductive by incorporating solutions of salt ions, conductive polymers, carbon compounds, or metal materials; by treatment from sulfosuccinic acid, or by cross-linking PVA to ionomeric polymers such as PFSA using glutaraldehyde (GA) or other aldehydes.

PVC—Polyvinylchloride (PVC, vinyl) is a thermoplastic insoluble in most solvents except for chlorinated hydrocarbon solvents. The rigidity of PVC depends on weight fraction of phthalate plasticizer added with under 25% considered rigid or semi-rigid and over 50% categorized at vert flexible. For use in ion exchange membranes, PVC is functionalized by the process of sulfonization, using ethylenediamine and sulfuric acid to cleave and attach SO₃H ionomeric groups onto the mainchain resulting in sulfonated polyvinylchloride (sPVC).

PVDF—Polyvinylidene fluoride, a semi-crystalline thermoplastic partially perfluorinated polymer, offering enhanced thermal stability and lower cost. PVDF can be made conductive through treatment by silver nanoparticles or by blending with poly (methyl methacrylate)-co-poly (sodium-4-styrene sulfonate) (PMMA-co-PSSNa) using a solvent evaporation method. Made in accordance with this invention, further improvements to PVDF polymers include a reenforced endoskeletal support matrix, sacrificial and permanent fillers to control film porosity, and scavenger MOFs to protect against CO poisoning.

Sacrificial filler—A sacrificial filler is a compound introduced into the mold compound prior to IEM polymerization that by occupying some molar volume within the membrane reduces the atomic density of the polymer's atomic matrix. Subsequent removal of the sacrificial filler by dissolving in a solvent results in a vacancy in the membrane's atomic matrix called a sac pore in spaces once occupied by the sacrificial filler. In one embodiment of this invention the sacrificial filler is sugar and the solvent used to remover it, is water. At sufficiently high sacrificial filler concentrations, the resulting sac pores merge together forming a network of channels enhancing vehicular charge transport of hydronium ions yet impeding crossover of larger fuel molecules like methanol. Described in the lexicon of apparatus claims, a membrane containing sacrificial filler molecules at time t₁ immediately after polymerization comprises an atomic matrix of polymer mainchains with a lower density than the same matrix had the sacrificial filler not been present. The same membrane at time t₂ after the filler is removed comprises an identical atomic density of polymer chains but now includes sac pores in every location previously occupied by the sacrificial filler. In alternative description, a membrane containing a sacrificial filler weighs more than a membrane once the sacrificial filler has been removed.

Scavenger—A compound or transition metal or MOF used to sequester and potentially degrade environmental toxins such as NO and unwanted reaction byproducts such as H₂O₂ from reaching and degrading the catalyst layer and the membrane's ionomers.

Singulation—The process of laser cutting an exoskeletal pillars to separate a membrane matrix into multiple IEMs, detaching them from one another and from the membrane frame holding the sheet together during processing.

Skeleton—An inventive feature for mechanically reinforcing an ion exchange membrane with a grid-like pattern of inert pillars having greater strength and rigidity than the ionomeric polymer comprising the conductive portions of the membrane. The skeletal structure may comprise stronger or more hydrophobic polymers than the membrane's conductive regions and may include strengthening fillers of carbon fibers, carbon nanotubes, plastic shards, or graphene. The skeletal matrix may include three components, an endoskeleton located throughout the membrane, an exoskeleton, comprising a wider skeletal pillar circumscribing the membrane, and a frame comprising a thicker or stronger support for mechanical handling holding one-or-more exoskeletal pillars in place during manufacturing. The frame attaches to the exoskeleton through tie bars removed during singulation.

Thermoplastic—A thermoplastic is any high molecular weight plastic polymer which is pliable or moldable at elevated temperatures and solidifies upon cooling. Thermoplastics include acrylics (PAA, PMMA), polystyrene (PS, ABS), polyamide (PAm), polybenzimidazole (PBI), polycarbonate (PC), polyether sulfone (PES), polysulfone (PSU, PSf), polyoxymethylene (POM), polyether ether ketone (PEEK) and other members of the polyaryletherketone (PAEK) family, polyetherimide (PEI), polyethylene (polyethene, polythene, PE), various polyphenylenes (PPh or PP), polypropylene (PP), polystyrene (PS), polyvinyl chloride (PVC), polyvinylidene fluoride (PVDF), and polytetrafluoroethylene (PTFE, Teflon®). Unlike polyolefins which represent a class of polymers defined by the molecular structure, thermoplastics are categorized by the material properties, specifically melting point, irrespective of its chemical structure or composition. Thermoplastic can be converted into ionomeric polymers by functionalization, the process of introducing mobile charge through sulfonation, grafting, copolymerization, radiation damage, or by doping the film with ionomeric nanoparticles, metal organic frameworks, proton ionic liquids, and other fillers.

Tripolar plate—A tripolar plate or TPP is an electrically conductive plate used to carry gas to the MEA5 fuel cell assembly transporting fuel to the anode, oxygen or air to the cathode, and carrying liquid coolant or forced air through the fuel cell.

Vehicular ion transport—The conduction of mobile ionic charges not involving membrane bound ionomers. In PEM conduction, vehicular transport may involve free protons H⁺, protons in solution (H⁺·H₂O), or hydronium ions (H₃O⁺). In AEM conduction, vehicular transport may involve hydroxyl ions —OH or hydrated hydroxide (OH⁻·H₂O).

1. An ion exchange membrane comprising an electrically conductive polymer matrix capable of conducting either cations or anions but not both;
where the polymer contains a hydrophobic polymeric backbone providing structure and mechanical support to the membrane;
where hydrophilic functional groups are attached either directly onto the backbone or indirectly at the terminus of a sidechain pendant molecule bonded or grafted onto the polymer mainchain;
where the functional groups comprise a membrane bound acid or base readily ionized into an immobile anionic or cationic ionomer, by which mobile charged ions such as protons, hydronium, or hydroxide ions may attach and detach to facilitate hopping conduction through the polymeric matrix;
where the membrane contains a skeletal matrix of inert pillars circumscribing and subdividing the conductive ionomeric membrane into panes; and
where the skeletal matrix chemically bonds to the panes of conductive ionomeric polymers forming a unitary ion conduction membrane having both mechanical strength and electrical conductivity.

2. The apparatus of claim 1 where the membrane is an proton exchange membrane, the ionomers comprise immobile anions, and where the transported charge comprises hydrogen and hydronium ions.

3. The apparatus of claim 1 where the membrane contains a membrane acid of sulphonic or phosphonic acid.

4. The apparatus of claim 1 where the acid group is attached to the terminus of a sidechain pendant bonded to the mainchain.

5. The apparatus of claim 1 where the conductive membrane comprises a fluorocarbon homopolymer such as PFSA or heteropolymer such as PFSA-PTFE.

6. The apparatus of claim 1 where the conductive membrane comprises a functionalized hydrocarbon polymer such as a blend of arylene, ether, ketone, nitrile, sulfone,

7. The apparatus of claim 6 where the hydrocarbon polymer is functionalized by sulphonic, phosphonic, or phosphoric acids.

8. The apparatus of claim 1 where the membrane is coated with PTFE nanospheres.

9. The apparatus of claim 1 where the skeletal pillars comprise an inert hydrophobic material.

10. The apparatus of claim 9 where the skeletal pillar is bonded to the ionomeric polymer by an intervening linking compound such as a molecular glue or polyvinyl alcohol.

11. The apparatus of claim 9 where the skeletal pillar is co-molded with the ionomeric polymer, i.e. polymerized concurrently.

12. The apparatus of claim 9 where the skeletal pillar of claim 10 has a roughened surface from a chemical or radiation pretreatment before being molded with the ionomeric polymer.

13. The apparatus of claim 1 where the skeletal matrix is defined by a casting mold with a mold chaise inserted into the mold cavity to limit where the skeletal matrix is formed.

14. The apparatus of claim 13 where the mold compound filling the skeletal regions includes a combination of organic monomers, cross-linkers, and strengthening fillers such as carbon fiber.

15. The apparatus of claim 14 where the cross linkers invoke complete polymerization of the skeletal support

16. The apparatus of claim 15 where the remaining unoccupied space in the mold cavity after the mold chaise insert has been removed is filled with organic monomers and cross-linkers during which polymerization of the ionomeric polymer bonds to the fully polymerized skeleton.

17. The apparatus of claim 16 where the cross linkers cause only partially polymerize the skeletal support.

18. The apparatus of claim 17 where the remaining unoccupied space in the mold cavity after the mold chaise insert has been removed is filled with organic monomers and cross-linkers during which polymerization of the ionomeric polymer bonds and copolymerizes the partially polymerized skeleton.

19. The apparatus of claim 1 where an ion exchange membrane where the skeletal support matrix includes wide and narrow pillars, where the sheet of multiple ion exchange membranes has been singulated along the wider pillars.

20. An ion exchange membrane comprising an electrically conductive polymer matrix capable of conducting either cations or anions but not both;
where the polymer contains a hydrophobic polymeric backbone providing structure and mechanical support to the membrane;
where hydrophilic functional groups are attached either directly onto the backbone or indirectly at the terminus of a sidechain pendant molecule bonded or grafted onto the polymer mainchain;
where the functional groups comprise a membrane bound acid or base readily ionized into an immobile anionic or cationic ionomer, by which mobile charged ions such as protons, hydronium, or hydroxide ions may attach and detach to facilitate hopping conduction through the polymeric matrix;
where the membrane contains a sacrificial filler molecule such as sugar after molding.

21. The apparatus of claim 22 where the sacrificial filler is no longer present in the membrane.
